(19) United States
(12) Patent Application Publication
(10) Pub. No.: US 2023/0364674 A1
(43) Pub. Date: Nov. 16, 2023

(54) METHOD FOR THE OBTAINING OF COST EFFECTIVE GEOMETRICALLY COMPLEX PIECES

(71) Applicant: ROVALMA, S.A., Rubi (ES)

(72) Inventor: Isaac VALLS ANGLÉS, Rubí (ES)

(73) Assignee: ROVALMA, S.A., Rubí (ES)

(21) Appl. No.: 17/801,169

(22) PCT Filed: Feb. 22, 2021
(86) PCT No.: PCT/EP2021/054352

§ 371 Date: Aug. 19, 2022

(30) Foreign Application Priority Data
Feb. 21, 2020 (ES) P 202030153
Jun. 15, 2020 (ES) P202030581
Aug. 5, 2020 (ES) P202030839
Jan. 29, 2021 (ES) P 202130077

(51) Int. Cl. B22F 3/14; B22F 10/28; B33Y 80/00; B22F 10/14; B22F 5/08; B33Y 10/00; B22F 3/12; B22F 5/00; C22C 38/58; C22C 38/50; C22C 38/48; C22C 38/44; C22C 38/38; C22C 38/28; C22C 38/06; C22C 38/04; C22C 38/00; C22C 38/30; C22C 38/02; C22C 38/24; C22C 38/22; C22C 38/20; C22C 38/46; C22C 38/52; C22C 38/10; C22C 38/12; C22C 38/14; C22C 14/00; C22C 19/05; C22C 9/04; C22C 9/06; C22C 9/02; C22C 9/01; C22C 19/07; C22C 21/18; C22C 21/16; C22C 21/06; C22C 23/02; C22C 29/08; C22C 29/06; C22C 29/10; B22F 3/24

(52) U.S. Cl. CPC B22F 3/14; B22F 10/28; B33Y 80/00; B22F 10/14; B22F 5/08; B33Y 10/00; B22F 3/1258; B22F 5/007; C22C 38/58; C22C 38/50; C22C 38/48; C22C 38/44; C22C 38/38; C22C 38/28; C22C 38/06; C22C 38/04; C22C 38/002; C22C 38/001; C22C 38/30; C22C 38/02; C22C 38/24; C22C 38/22; C22C 38/20; C22C 38/46; C22C 38/52; C22C 38/005; C22C 38/008; C22C 38/105; C22C 38/12; C22C 38/14; C22C 14/00; C22C 19/057; C22C 19/056; C22C 19/055; C22C 19/053; C22C 9/04; C22C 9/06; C22C 9/02; C22C 9/01; C22C 19/07; C22C 21/18; C22C 21/16; C22C 21/06; C22C 23/02; C22C 29/08; C22C 29/067; C22C 29/10; B22F 3/24; B22F 2998/10; B22F 2301/35; B22F 2301/205; B22F 2301/15; B22F 2301/10; B22F 2301/052; B22F 2301/058; B22F 2302/10; B22F 2003/247; B22F 2003/248

(57) ABSTRACT

The present invention relates to a method for producing metal-comprising geometrically complex pieces and/or parts. The method is specially indicated for highly performant components. It is disclosed a method for the production of complex geometry, and even large, highly performant metal-comprising components in a cost effective way. The method is also indicated for the construction of components with internal features and voids. The method is also beneficial for light construction. The method allows the reproduction of bio-mimetic structures and other advanced structures for topological performance optimization.

### FIELD OF THE INVENTION

The present invention relates to a method for producing metal-comprising geometrically complex pieces and/or parts (components). The method is especially indicated for highly performant components. The method is also indicated for manufacturing very large components. The method is also indicated for the construction of components with internal features and voids. The method is also beneficial for light construction. The method allows the reproduction of bio-mimetic structures and other advanced structures for topological performance optimization.

### SUMMARY

Technological advancement is strongly influenced by the available materials and the designs that can be implemented to best capitalize those properties for a given application. In the history of human kind innovation, many efforts have been devoted to the development of materials with improved properties and to the development of new designs to execute production or implementation methods, as can be also recognized by the extense amount of patent applications relating to those two topics. The attainable designs are not only limited by the capacity of vision of the inventors and designers but also by the available manufacturing capabilities that must allow the implementation of the projected designs.

In recent years, with the development of advanced fabrication methodologies allowing for great design flexibility, like several additive manufacturing (AM) methods, have allowed a great advancement in the development of topologically optimized designs also in the micro-scale especially with the advancements in the studying of prominent microstructures in nature. Also departing from biomimetic structures, further optimizations have followed for even additional optimization of properties and property compromises for certain applications.

Material development seems to lag a bit behind, especially when it comes to metals and metal comprising materials, and it is still challenging to find materials that outperform in all relevant properties the wrought materials currently used, and some further challenges have arisen like the inherent anisotropy tendency of most AM methods for metals. Besides performance, metals for AM are orders of magnitude more expensive than their wrought construction counterparts, and the existing AM methods for metals are also very cost intensive. Currently the construction of large, high performant, AM metal components is an extreme technical and economical challenge. Most existing AM technologies present excessive residual stresses and even cracks when trying to achieve large complex geometries.

The present invention helps overcome many of the challenges related to metal AM both in the sense of performance and cost, while keeping the very advantageous flexibility of design. Thus, the present invention is especially indicated for the manufacturing of high performant components with complex geometries, the manufacture of large components with complex geometries, and generally any component that can benefit from great flexibility of design at low cost and high performance. The present invention is especially well suited for metallic or at least metal comprising components, but other material types can also benefit from it.

### STATE OF THE ART

There are a lot of inventions relating to the obtaining of complex geometries with metals, especially since the flourishing of AM technologies. In most of these technologies it is close to impossible to obtain isotropic, crack free, complex geometry components, especially when those components are large in size. Also, most of the existing AM methods are very cost intensive and not capable of producing components with large dimensions. Some other technologies not considered AM, for the obtaining of complex geometries, present severe difficulties for the obtaining of components with internal features without cracks.

Patent application number PCT/EP2019/075743 describe a method for manufacturing components. The present invention discloses several new developments, in order to obtain components with improved mechanical properties and new design strategies which can be combined with manufacturing methods.

### DESCRIPTION OF DRAWINGS

FIG. 1. Cooling circuit detail with main channels, secondary channels and fine channels.

FIG. 2. Cooling circuit detail with branched main channels acting as collectors and fine channels between them.

FIG. 3. Cooling circuit detail with main cylindrical channels acting as collectors with square profile with rounded edges fine channels.

FIG. 4. Two examples of components with voids.

FIG. 5. Cross section of a die with cooling circuit and voids, some of the fine channels rectangular cross section with rounded edges can be seen as well as the distance to the thermo-regulated surface.

FIG. 6. Bird-eye view of a die with cooling channels and voids made of 9 joined segments each manufactured with a different technology amongst the ones described in this document and joined as described in this document after the consolidation step. The 3 upper segments were manufactured trough using additive manufacturing methods comprising an organic material and comprising as well a metallic material in particulate form. The 3 mid-line segments were manufactured using additive manufactured molds filed with metallic materials in particulate form. The 3 bottom segments were manufactured were manufactured using additive manufacturing methods comprising a metallic material in particulate or wire form.

FIG. 7. Organic material mold made of several different smaller additive manufacturing manufactured smaller pieces ensembled together ready to be filled with metal comprising material in particulate form.

FIG. 8. For a given component with voids (a), Rectangular Cuboid (b), largest rectangular face of the rectangular cuboid (b), cross-section percentile (c), cross section for the 80^{th} percentile −76.5 cm²-(c), mean cross-section obtained when 20% of the largest cross-sections and 20% of the smallest cross-sections are not considered—56.91 cm²-(c), cuboid shaped with the working surface of the component (d) with a cross-section for better understanding (e).

FIG. 9. Representation of VOXEL concept for understanding purposes.

### DETAILED DESCRIPTION OF THE INVENTION

Currently the layered manufacturing methods for metal components are anisotropic, quite slow and therefore costly and it is challenging to obtain all properties of the bulk material counterparts, although this is often compensated and exceeded with the flexibility of design. Also, those methods tend to incorporate high levels of residual stresses due to the very localized energy application, which becomes very challenging when trying to manufacture large components. With smaller components of high complexity, the residual stress problem is tackled with the use of supporting structures which add cost and also have their limitations. On the other hand, plastic material AM can be quite faster and cost effective, especially when the mechanical performance of the manufactured component is not the main interest, and even more so when dimensional tolerances are not too tight. The AM technologies that can be categorized as direct energy deposition (DeD) are normally somewhat more cost effective, allow for the manufacture of larger components, but normally as a deposition to an underlying material, when constructing from scratch components of a certain thickness, the residual stresses become not-manageable and almost in all executions the spectra on materials where some resemblance to the wrought material performance can be attained, is very limited.

There are other methods to manufacture complex geometry components using metallic materials like:
Metal injection molding (MIM): which allows quite high dimensional accuracies, with reasonable costs, not extremely good performance but often enough acceptable. This method is constrained to very smart components.
Hot isostatic pressing (HIP) of canned powders: which allows for the manufacturing of large components, but just for simple geometries with no internal features. The cost is reasonable but still high for most applications.
Cold isostatic pressing (CIP) in rubber molds: more than reasonable cost, but with poor dimensional accuracy, often problems with internal cracks for complex geometries and even more so in large components, and very difficult to attain high performance in many industrial interesting alloying systems. Internal features only possible for very simple geometries using special cores which significantly increase the cost.

In an embodiment, the use of terms such as “below”, “above”, “or more”, “from,” “to,” “up to,” “at least,” “greater than”, “higher than”, “more than”, “less than” and the like throughout the disclosure, include the number recited.

The inventor has found that, for some applications, the use of certain geometrical design strategies to manufacture a component is advantageous. Some of the components which may benefit from a proper geometrical design strategy include, but are not limited to: pieces, molds, dies, plastic injection molds or dies, die casting dies, light alloy die casting dies, aluminium die casting dies, drawing dies or molds, cutting dies or molds, bending dies and/or molds. The inventor has found that for a given application, the selection of a certain design of the component may be very important. In this regard, the inventor has surprisingly found that for several tooling applications, the manufacture of a component with a mixture of metal with air is very advantageous. In an embodiment, the manufactured component is for tooling applications. In an embodiment, tooling applications refers to plastic injection. In another embodiment, tooling applications refers to die casting. In another embodiment, tooling applications refers to light alloy die casting. In another embodiment, tooling applications refers to aluminium die casting. In another embodiment, tooling applications refers to drawing applications. In another embodiment, tooling applications refers to cutting applications. In another embodiment, tooling applications refers to bending applications. The inventor has found that the proper geometrical design strategy disclosed in the following paragraphs can be advantageously used to manufacture at least part of different components. In an embodiment, the component is a die. In another embodiment, the component is a plastic injection die. In another embodiment, the component is a die casting die. In another embodiment, the component is a light alloy die casting die. In another embodiment, the component is an aluminium die casting die. In another embodiment, the component is a drawing die. In another embodiment, the component is a cutting die. In another embodiment, the component is a bending die. In another embodiment, the component is a mold. In another embodiment, the component is a drawing mold. In another embodiment, the component is a cutting mold. In another embodiment, the component is a bending mold. The inventor has found that, for some applications, the proper geometrical design strategy may involve a significant reduction of the volume and/or weight of the manufactured component. As previously disclosed, for several applications, the manufacture of a component comprising a mixture of metal with air is very advantageous. Unless otherwise stated, the feature “proper geometrical design strategy” is defined throughout the present document in the form of different alternatives, that are explained in detail below. In an embodiment, the proper geometrical design strategy comprises the manufacture of a component with a certain content of voids. For some applications, it is particularly interesting to calculate the percentage of voids of the manufactured component. In this regard, a rectangular cuboid with the minimum possible volume that contains the manufactured component can be used for comparative purposes. Unless otherwise stated, the term “rectangular cuboid” is defined throughout the present document as the rectangular cuboid with the minimum possible volume that contains the component. In the meaning of this document, a rectangular cuboid or rectangular hexahedron is a convex polyhedron bounded by six rectangular faces (and so its pair of adjacent faces meets in a right angle). In different embodiments, the volume percentage of the rectangular cuboid that is void is more than 52%, more than 62%, more than 76%, more than 86%, more than 92% and even more than 96%. For certain applications, the volume percentage of the rectangular cuboid that is void, should be limited. In different embodiments, the volume percentage of the rectangular cuboid that is void is less than 99%, less than 94% and even less than 89%. In an embodiment, the volume percentage of the rectangular cuboid that is void means the volume percentage of the rectangular cuboid not occupied by the component. As previously disclosed, the rectangular cuboid used to calculate the volume percentage that is void is the rectangular cuboid with the minimum possible volume that comprises the component. In an embodiment, the manufactured component comprises voids. In an embodiment, the feature “voids” refers to a geometrical aspect that is located in an interior volume of a component and that may or may not be in direct communication with at least one external surface of the component through one exterior opening defined in the external surface of the component. In an embodiment, the voids exclude the geometrical aspects that are part of the design of the component, this means that for example, if the component comprises a cooling channel, void or cavity which is part of the design of the component, this geometrical aspect is not considered to calculate the voids. The inventor has surprisingly found that, for some applications, the performance of the component is advantageously improved when at least part of the voids are interconnected. In an embodiment, the component comprises interconnected voids. In an embodiment, at least some of the voids are interconnected. In different embodiments, some of the voids refer to 2 or more voids, 11 or more voids, 51 or more voids, 120 or more voids and even 520 or more voids. For some applications, a limited number of interconnected voids is preferred. In different embodiments, some of the voids refer to less than 10000 voids, to less than 4000 voids, to less than 990 voids, to less than 490 voids, to less than 34 voids and even to less than 19 voids. For some applications, some of the voids refer to a certain percentage of voids. In different embodiments, some of the voids refer to at least 6% of the voids, to at least 12% of the voids, to at least 26% of the voids, to at least 46% of the voids and even to at least 56% of the voids. For some applications, higher percentages are advantageous. In different embodiments, some of the voids refer to at least 66% of the voids, to at least 76% of the voids, to at least 86% of the voids, to at least 91% of the voids and even to at least 97% of the voids. For some applications, even some of the voids refer to all the voids of the component. For some applications, the percentage of interconnected voids should be limited. In different embodiments, some of the voids refer to less than 99% of the voids, to less than 96% of the voids, to less than 94% of the voids, to less than 84% of the voids, to less than 79% of the voids, to less than 54% of the voids and even to less than 44% of the voids. In some embodiments, at least part of the voids are connected to the outside of the component. In an embodiment, the manufactured component comprises voids connected to the outside of the component. In an embodiment, the feature “voids connected to the outside of the component” refers to geometrical aspects that are located in an interior volume of a component and that are in direct communication with at least one external surface of the component through an exterior opening defined in the external surface of the component. In an embodiment, the voids connected to the outside of the component exclude the geometrical aspects that are part of the design of the component, this means that for example, if the component comprises a cooling channel, void or cavity directly connected with the external surface of the component which is part of the design of the component, this geometrical aspect is not considered to calculate the voids connected to the outside of the component. In different embodiments, the percentage of voids connected to the outside of the component is at least 6%, at least 11%, at least 21%, at least 41% and even at least 61%. For some applications, higher percentages are advantageous. In different embodiments, the percentage of voids connected to the outside of the component is at least 76%, at least 81%, at least 86%, at least 91%, at least 98%. In some particular embodiments, even all the voids are connected to the outside of the component. For some applications, the percentage of voids connected to the outside of the component should be limited. In different embodiments, the percentage of voids connected to the outside of the component is less than 99%, less than 94%, less than 89%, less than 74%, less than 64% and even less than 49%. In an embodiment, voids comprise porosity. In another embodiment, voids comprise only porosity. In an embodiment, the above disclosed about the component refers to the manufactured component. All the embodiments disclosed above can be combined among them in any combination, provided that they are not mutually exclusive, for example a component comprising less than 10000 voids, wherein at least 41% of the voids are connected to the surface of the component. Air is known to be an extremely good isolator, but very surprisingly when choosing the right alloying system and a smart design full of voids (much means full of air), the thermal performance of the manufactured component can be boosted. In an embodiment, the manufactured component has outstanding thermal performance. The inventor has found that for some applications it is particularly interesting to adapt the design to the alloying system in order to improve the hardenability of the manufactured component. Currently, the manufacture of large components with homogeneous, high mechanical properties is very difficult to be achieved. Furthermore, when a certain thermal behavior is also required (for example, particularly low thermal conductivity, high thermal conductivity or low heat capacity), then the challenge becomes impossible. For some applications, it is particularly challenging when the mechanical properties involve toughness. The inventor has surprisingly found that, for some applications, the problem of manufacturing large components having homogeneous, high mechanical properties and even high thermal performance can be solved when the proper geometrical design strategy is carefully selected. In an embodiment, the proper geometrical design strategy comprises the manufacture of a component with a certain significant cross-section. Unless otherwise stated, the feature “significant cross-section of the component” is defined throughout the present document in the form of different alternatives, that are explained in detail below. In an embodiment, the significant cross-section is the largest cross-section of the component. In an alternative embodiment, the significant cross-section of the component is the mean cross-section. In another alternative embodiment, the significant cross-section of the component is the mean cross-section obtained when the 20% of the largest cross-sections and the 20% of the lowest cross-sections are not considered to calculate the mean cross-section. For some applications, at least some of the largest cross-sections should not be considered to calculate the significant cross-section. In an embodiment, the significant cross-section of the component is the largest cross-section obtained after excluding the 10% of the largest cross-sections (this means that in an ordered distribution from the smallest cross-section (0% percentile) to the largest cross-section (100% percentile), 10% corresponds to 100%-10%=90% of the percentile). In another embodiment, the significant cross-section of the component is the largest cross-section obtained after excluding the 15% of the largest cross-sections. In another embodiment, the significant cross-section of the component is the largest cross-section obtained after excluding the 20% of the largest cross-sections. In another embodiment, the significant cross-section of the component is the largest cross-section obtained after excluding the 30% of the largest cross-sections. In another embodiment, the significant cross-section of the component is the largest cross-section obtained after excluding the 40% of the largest cross-sections. In another embodiment, the significant cross-section is the largest cross-section obtained after excluding the 50% of the largest cross-sections. In another embodiment, the significant cross-section of the component is equal to the cross-section value that corresponds to the 90^{th} percentile. In another embodiment, the significant cross-section of the component is equal to the cross-section value that corresponds to the 80^{th} percentile. In another embodiment, the significant cross-section of the component is equal to the cross-section value that corresponds to the 70^{th} percentile. In another embodiment, the significant cross-section of the component is equal to the cross-section value that corresponds to the 60^{th} percentile. In another embodiment, the significant cross-section of the component is equal to the cross-section value that corresponds to the 50^{th} percentile. In an embodiment, a cross-section is significant, when at least 20% of the cross-sections are within the range. In another embodiment, a cross-section is significant, when at least 40% of the cross-sections are within the range. In another embodiment, a cross-section is significant, when at least 60% of the cross-sections are within the range. In another embodiment, a cross-section is significant, when at least 80% of the cross-sections are within the range. In another embodiment, a cross-section is significant, when all the cross-sections are within the range. For some applications, the proper geometrical design strategy may involve a significant reduction of the significant cross-section of the manufactured component. In an embodiment, the proper geometrical design strategy comprises a certain relation between the significant cross-section of the component (as previously defined) and the area of the largest rectangular face of the rectangular cuboid (as previously defined). In different embodiments, the significant cross-section of the component is 0.79 times or less, 0.69 times or less, 0.59 times or less, 0.49 times or less, 0.39 times or less, 0.29 times or less, 0.19 times or less and even 0.09 times or less the area of the largest rectangular face of the rectangular cuboid (as previously defined). In some cases, extremely low values are of especial interest. In different embodiments, the significant cross-section of the component is 0.04 times or less, 0.019 times or less, 0.009 times or less, 0.0009 times or less and even 0.0002 times or less the area of the largest rectangular face of the rectangular cuboid (as previously defined). For some applications, a certain relation between the significant cross-section of the component (as previously defined) and the area of the largest rectangular face of the rectangular cuboid (as previously defined) is preferred. In different embodiments, the significant cross-section of the component is less than 49%, less than 19%, less than 9% and even less than 4% of the area of the largest rectangular face of the rectangular cuboid. For certain applications, particularly for components requiring high mechanical properties and/or low weight, lower values are preferred. In different embodiments, the significant cross-section of the component is less than 1.9%, less than 0.9% and even less than 0.09% of the area of the largest rectangular face of the rectangular cuboid (as previously defined). In the meaning of this document, the area of the largest rectangular face of the rectangular cuboid is the largest area among all the areas of the rectangular faces of the rectangular cuboid (If the dimensions of a rectangular cuboid are a, b and c, the area of the largest rectangular face refers to the largest value among a*b, a*c and b*c). In an embodiment, the cross-section refers to the cross-sectional area. For some applications, the cross-sections of the component can be calculated, using the minimum cross-sections of the component associated to the voxels that are totally comprised in the component (this means that the voxels that are at least partly outside of the component are not considered to calculate the cross-sections, accordingly, only the voxels that are full of component are considered). In an alternative embodiment, the voxels with a geometrical center that is not inside the component are excluded. In some embodiments, the reference to the geometrical center of the voxel through this document can be substituted by the gravity center of the voxel. In an embodiment, the gravity center of the voxel is calculated considering homogeneous density. In an embodiment, the density is the mean density of the component. In an embodiment, a voxel refers to a polyhedron with a cubic geometry (hereinafter referred as “cubic voxel”). Unless otherwise stated, the term “cubic voxel” is defined throughout the present document as a polyhedron with a cubic geometry. In an embodiment, there is at least one cubic voxel having a geometrical center that is coincident with the geometrical center of the rectangular cuboid (as previously defined). In some embodiments, the reference to the geometrical center of the rectangular cuboid (as previously defined) through this document can be substituted by the gravity center of the rectangular cuboid (as previously defined). In an embodiment, the gravity center of the rectangular cuboid (as previously defined) is calculated considering homogeneous density. In an embodiment, the density is the mean density of the component. In an embodiment, the cubic voxel and the rectangular cuboid (as previously defined) have parallel faces. In an embodiment, there is at least one cubic voxel having a geometrical center that is coincident with the geometrical center of the rectangular cuboid (as previously defined), with parallel faces to such rectangular cuboid and a defined edge length. In different embodiments, the edge length of the cubic voxel is 1 mm, 0.9 mm, 0.09 mm, 0.04 mm, 0.01 mm, 0.009 mm and even 0.001 mm. In an embodiment, there is a minimum cross-section of the component that can be calculated for each cubic voxel. In an embodiment, the minimum cross-section of the component associated to any point comprised in the cubic voxel is defined as the minimum cross-section of the component associated to the cubic voxel. In an embodiment, the minimum cross-section of the component associated to a cubic voxel is the minimum cross-section of the component comprising the geometrical center of the cubic voxel. In another embodiment, the minimum cross-section of the component associated to a cubic voxel is the minimum cross-section of the component comprising the gravity center of the cubic voxel. In another embodiment, the minimum cross-section of the component associated to a cubic voxel is the minimum cross-section of the component comprising the gravity center of the cubic voxel, considering homogeneous density wherein the density is the mean density of the component. In an embodiment, a cross-section comprising a given point is the area of the geometrical figure defined by the component and an infinite plane cutting the component and comprising the given point (there are infinite possible planes but only one with a maximum/minimum cross-section). In an embodiment, the cross-sections of the component are the minimum cross-sections associated to the cubic voxels fully contained in the component. In an embodiment, the cubic voxels used to calculate the cross-sections are the cubic voxels that are fully contained in the component. For some applications, the use of voxels with a rectangular cubic geometry is preferred. Unless otherwise stated, the term “rectangular cubic voxel” is defined throughout the present document as a polyhedron with a rectangular cubic geometry. In an alternative embodiment, a voxel refers to a polyhedron with a rectangular cubic geometry (hereinafter referred as “rectangular cuboid voxel”) and with a downsizing in respect of the rectangular cuboid (as previously defined). In an embodiment, all the rectangular cuboid voxels are contained in the rectangular cuboid. In an embodiment, the rectangular cuboid is full of rectangular cuboid voxels. In an embodiment, all the rectangular cuboid voxels have the same volume. In an embodiment, there is a certain relation between the volume of the rectangular cuboid voxels (Vrc) and the volume of the rectangular cuboid (as previously defined) according to the following formula: Vrc=V/n³ wherein Vrc is the volume of the rectangular cuboid voxel in m³, V is the volume of the rectangular cuboid (as previously defined) in m³ and n³ is the number of rectangular cuboid voxels that are contained in the rectangular cuboid (as previously defined). In an embodiment, n is a natural number. In different embodiments, n is higher than 11, higher than 110, higher than 560, higher than 1050, higher than 5600 and even higher than 10500. For some applications, n should be limited. In different embodiments, n is less than 990000, less than 94000, less than 44000, less than 19400, less than 9400 and even less than 4800. All the embodiments disclosed above can be combined among them in any combination, provided that they are not mutually exclusive, for example n is higher than 110 and less than 990000. In an embodiment, n is 12. In another embodiment, n is 120. In another embodiment, n is 580. In another embodiment, n is 1060. In another embodiment, n is 4400. In another embodiment, n is 5800. In another embodiment, n is 9100. In another embodiment, n is 10600. In another embodiment, n is 19100. In another embodiment, n is 41000. In another embodiment, n is 91000. In an embodiment, n is 980000. In an embodiment, there is a minimum cross-section that can be calculated for each rectangular cuboid voxel. In an embodiment, the minimum cross-section of the component associated to any point comprised in the rectangular cuboid voxel is defined as the minimum cross-section of the component associated to the rectangular cuboid voxel. In an embodiment, the minimum cross-section of the component associated to a rectangular cuboid voxel is the minimum cross-section of the component comprising the geometrical center of the rectangular cuboid voxel. In another embodiment, the minimum cross-section of the component associated to a rectangular cuboid voxel is the minimum cross-section of the component comprising the gravity center of the rectangular cuboid voxel. In another embodiment, the minimum cross-section of the component associated to a rectangular cuboid voxel is the minimum cross-section of the component comprising the gravity center of the rectangular cuboid voxel, considering homogeneous density wherein the density is the mean density of the component. In an embodiment, a cross-section comprising a given point is the area of the geometrical figure defined by the component and an infinite plane cutting the component and comprising the given point (there are infinite possible planes but only one with a maximum/minimum cross-section). In an embodiment, the cross-sections of the component are the minimum cross-sections associated to the rectangular cuboid voxels fully contained in the component. In an embodiment, the rectangular cuboid voxels used to calculate the cross-section are the rectangular cuboid voxels that are fully contained in the component. In different embodiments, the significant cross-section of the component (as previously defined) is more than 0.2 mm², more than 2 mm², more than 20 mm², more than 200 mm² and even more than 2000 mm². For some applications, the significant cross-section should be maintained below a certain value. In different embodiments, the significant cross-section of the component (as previously defined) is less than 2900000 mm², less than 900000 mm², less than 400000 mm², less than 90000 mm², less than 40000 mm² and even less than 29000 mm². The inventor has found that in some designs, particularly for components requiring high mechanical properties, smaller significant cross-sections are preferred. In different embodiments, the significant cross-section of the component (as previously defined) is less than 9000 mm², less than 4900 mm², less than 2400 mm², less than 900 mm², less than 400 mm², less than 190 mm², less than 90 mm² and even less than 40 mm². In an embodiment, the significant cross-section means the significant cross-sectional area. The inventor has found that for some applications, the proper geometrical design strategy comprises the manufacture of a component with a certain cross-section. In different embodiments, the cross-section of the component is more than 0.2 mm², more than 2 mm², more than 20 mm², more than 200 mm² and even more than 2000 mm². For some applications, the cross-section should be maintained below a certain value. In different embodiments, the cross-section of the component is less than 2900000 mm², less than 900000 mm², less than 400000 mm², less than 90000 mm², less than 40000 mm² and even less than 29000 mm². The inventor has found that in some designs, particularly for components requiring high mechanical properties, lower cross-sections are preferred. In different embodiments, the cross-section of the component is less than 9000 mm², less than 4900 mm², less than 2400 mm² and even less than 900 mm². For some applications, even lower cross-sections are preferred. In different embodiments, the cross-section of the component is less than 400 mm², less than 190 mm², less than 90 mm² and even less than mm². In an embodiment, the cross-section is the mean cross-section. In an embodiment, the cross-section means the cross-sectional area. All the embodiments disclosed above can be combined among them in any combination, provided that they are not mutually exclusive, for example: in an embodiment, the mean cross-section of the component is more than 0.2 mm² and less than 49% of the area of the largest rectangular face of a rectangular cuboid with the minimum possible volume that contains the component; or for example: in an embodiment, the mean cross-section of the component is more than 0.2 mm² and less than 2900000 mm²; or for example: in another embodiment, the largest cross-section of the component is more than 0.2 mm² and less than 49% of the area of the largest rectangular face of a rectangular cuboid with the minimum possible volume that contains the component and is the largest cross-section obtained after excluding the 40% of the largest cross-sections of the component, wherein the cross-sections of the component are each of the minimum cross-sections of the component calculated from each cubic voxel with an edge length of 1 mm that is totally comprised in the component, provided that the minimum cross-section of the component associated to each cubic voxel is the minimum cross-section of the component that comprises the geometrical center of the cubic voxel and that there is at least one cubic voxel having a geometrical center that is coincident with the geometrical center of the rectangular cuboid and that the faces of the cubic voxels and the faces of the rectangular cuboid are parallel. In an alternative embodiment, the geometrical center is substituted by the gravity center; or for example: in another embodiment, the largest cross-section of the component is more than 0.2 mm² and less than 49% of the area of the largest rectangular face of a rectangular cuboid with the minimum possible volume that contains the component and is the largest cross-section obtained after excluding the 40% of the largest cross-sections of the component, wherein the cross-sections of the component are each of the minimum cross-sections of the component calculated from each rectangular cubic voxel that is totally comprised in the component, wherein the number of rectangular cuboid voxels comprised in the component is calculated from Vrc=V/n³ being Vrc the volume of the rectangular cubic voxels in m³, V the volume of the rectangular cuboid in m³ and n³ the number of rectangular cuboid voxels that are contained in the rectangular cuboid, being n higher than 11 and less than 990000, provided that the minimum cross-section of the component associated to each rectangular cubic voxel is the minimum cross-section of the component that comprises the geometrical center of the rectangular cuboid voxel. In an alternative embodiment, the geometrical center is substituted by the gravity center; or for example: in another embodiment, the largest cross-section of the component is more than 0.2 mm² and less than 49% of the area of the largest rectangular face of a rectangular cuboid with the minimum possible volume that contains the component and is the largest cross-section obtained after excluding the 40% of the largest cross-sections of the component, wherein the cross-sections of the component are each of the minimum cross-sections of the component calculated from each rectangular cubic voxel which is totally comprised in the component, wherein the number of rectangular cuboid voxels comprised in the component is calculated from Vrc=V/n³ being Vrc the volume of the rectangular cubic voxels in m³, V the volume of the rectangular cuboid in m³ and n³ the number of rectangular cuboid voxels that are contained in the rectangular cuboid, being n=1060, provided that the minimum cross-section of the component associated to each rectangular cubic voxel is the minimum cross-section of the component that comprises the geometrical center of the rectangular cuboid voxel. In an alternative embodiment, the geometrical center is substituted by the gravity center. In an embodiment, the proper geometrical design strategy comprises the manufacture of a component with a certain significant thickness. Unless otherwise stated, the feature “significant thickness of the component” is defined throughout the present document in the form of different alternatives, that are explained in detail below. In an embodiment, the significant thickness is the largest thickness of the component. In an alternative embodiment, the significant thickness of the component is the mean thickness. In another alternative embodiment, the significant thickness is the square root of the minimum cross-section of the component comprising the geometrical center of the cubic voxel. In another alternative embodiment, the significant thickness is the square root of the minimum cross-section of the component comprising the geometrical center of the rectangular cuboid voxel. In another alternative embodiment, the significant thickness is the square root of the minimum cross-section of the component comprising the gravity center of the cubic voxel. In another alternative embodiment, the significant thickness is the square root of the minimum cross-section of the component comprising the gravity center of the rectangular cuboid voxel. For some applications, at least some of the largest thicknesses should not be considered to calculate the significant thickness. In an embodiment, the significant thickness of the component is the largest thickness obtained after excluding the 10% of the largest thicknesses (this means that in an ordered distribution from the smallest thickness (0% percentile) to the largest thickness (100% percentile), 10% corresponds to 100%-10%=90% of the percentile). In another embodiment, the significant thickness of the component is the largest thickness obtained after excluding the 15% of the largest thicknesses. In another embodiment, the significant thickness of the component is the largest thickness obtained after excluding the 20% of the largest thicknesses. In another embodiment, the significant thickness of the component is the largest thickness obtained after excluding the 30% of the largest thicknesses. In another embodiment, the significant thickness of the component is the largest thickness obtained after excluding the 40% of the largest thicknesses. In another embodiment, the significant thickness is the largest thickness obtained after excluding the 50% of the largest thickness. In another embodiment, the significant thickness of the component is equal to the thickness value that corresponds to the 90^{th} percentile. In another embodiment, the significant thickness of the component is equal to the thickness value that corresponds to the 80^{th} percentile. In another embodiment, the significant thickness of the component is equal to the thickness value that corresponds to the 70^{th} percentile. In another embodiment, the significant thickness of the component is t equal to the thickness value that corresponds to the 60^{th} percentile. In another embodiment, the significant thickness of the component is equal to the thickness value that corresponds to the 50 percentile. In an embodiment, a thickness is significant, when at least 20% of the thicknesses are within the range. In another embodiment, a thickness is significant, when at least 40% of the thicknesses are within the range. In another embodiment, a thickness is significant, when at least 60% of the thicknesses are within the range. In another embodiment, a thickness is significant, when at least 80% of the thicknesses are within the range. In another embodiment, a thickness is significant, when all the thicknesses are within the range. In different embodiments, the significant thickness of the component (as previously defined) is more than 0.12 mm, more than 1.2 mm, more than 12 mm, more than 22 mm and even more than 112 mm. For some applications, too large thicknesses are disadvantageous. In different embodiments, the significant thickness of the component (as previously defined) is less than 1900 mm, less than 900 mm, less than 580 mm, less than 380 mm and even less than 180 mm. For some particular applications, smaller thicknesses are preferred. In different embodiments, the significant thickness of the component (as previously defined) is less than 80 mm, less than 40 mm, less than 19 mm, less than 9 mm and even less than 0.9 mm. In an embodiment, the proper geometrical design strategy comprises the manufacture of a component with a certain thickness. In different embodiments, the thickness of the component is more than 0.12 mm, more than 1.2 mm, more than 12 mm, more than 22 mm and even more than 112 mm. For some applications, too large thicknesses are disadvantageous. In different embodiments, the thickness of the component is less than 1900 mm, less than 900 mm, less than 580 mm, less than 380 mm and even less than 180 mm. In some particular applications, smaller thicknesses are preferred. In different embodiments, the thickness of the component is less than 80 mm, less than 40 mm, less than 19 mm, less than 9 mm and even less than 0.9 mm. In an embodiment, the thickness is the mean thickness. In an embodiment, the proper geometrical design strategy comprises the manufacture of a component with a certain volume. In an embodiment, there is a certain relation between the volume of the manufactured component and the volume of the rectangular cuboid (the rectangular cuboid with the minimum possible volume that contains the component, as previously defined). In different embodiments, the volume of the component is less than 89%, less than 74%, less than 68%, less than 49%, less than 39% and even less than 19% of the volume of the rectangular cuboid (as previously defined). For some applications, the volume should not be too low. In different embodiments, the volume the component is more than 2%, more than 6%, more than 12%, more than 22%, more than 44%, more than 49% and even more than 55% of the volume of the rectangular cuboid (as previously defined). In another embodiment, the volume comparison is made with the cuboid shaped with the working surface of the component. In this context, the cuboid shaped with the working surface of the component is defined as the rectangular cuboid with the minimum possible volume that contains the component, wherein the face of the rectangular cuboid that is in contact with the working surface of the component is substituted by a face with a geometrical shape that is coincident with the geometrical shape of the working surface of the component and has the minimum area possible. In different embodiments, the volume of the component is less than 89%, less than 74%, less than 68%, less than 49%, less than 39% and even less than 19% of the volume of the cuboid shaped with the working surface of the component (as previously defined). For some applications, the volume should not be too low. In different embodiments, the volume the component is more than 2%, more than 6%, more than 12%, more than 22%, more than 44%, more than 49% and even more than 55% of the volume of the maximum cuboid shaped with the working surface of the component (as previously defined). In an embodiment, the working surface refers to the active surface. In an alternative embodiment, the working surface refers to the relevant active surface. All the embodiments disclosed above can be combined among them in any combination, provided that they are not mutually exclusive, for example: in an embodiment, the significant thickness of the component is the square root of the minimum cross-section of the component, being the cross-sections of the component each of the minimum cross-sections of the component calculated from each cubic voxel with an edge length of 0.04 mm that is totally comprised in the component, provided that the minimum cross-section of the component associated to each cubic voxel is the minimum cross-section of the component that comprises the geometrical center of the cubic voxel and that there is at least one cubic voxel having a gravity center that is coincident with the geometrical center of the rectangular cuboid and that the faces of the cubic voxels and the faces of the rectangular cuboid are parallel, being the rectangular cuboid as previously defined; or for example: in another embodiment, the volume the manufactured component is more than 2% and less than 89% of the volume of a rectangular cuboid with the minimum possible volume that contains the component; or for example: in another embodiment, the significant thickness of the component is the square root of the minimum cross-section of the component, being the cross-sections of the component each of the minimum cross-sections of the component calculated from each rectangular cubic voxel totally comprised in the component, wherein the number of rectangular cuboid voxels comprised in the component is calculated as Vrc=V/n³, being Vrc the volume of the rectangular cubic voxels in m³, V the volume of the rectangular cuboid in m³ and n³ the number of rectangular cuboid voxels contained in the rectangular cuboid, being n=41000, provided that the minimum cross-section of the component associated to each rectangular cubic voxel is the minimum cross-section of the component that comprises the geometrical center of the rectangular cuboid voxel, and being the rectangular cuboid as previously defined.

In some applications, it is particularly interesting the manufacture of a component comprising channels. In an embodiment, the proper geometrical design strategy comprises the manufacture of a component comprising channels. When the distance between the channels and the surface of the component to be thermoregulated is high, the thermoregulation which may be achieved is not very effective. In some applications, when the cross-section of the channels is too large and the channels are located very close to the surface of the component to be thermoregulated, the possibilities of mechanical failure are largely increased. To solve this issue, the present invention proposes a combined system that replicates the blood transport in human body. In the same way, in the proposed system, the thermoregulation fluid (cold or hot depending on the thermoregulatory function) enters the component through the main channels and is carried from the main channels to secondary channels (there may be different levels of secondary channels, this means, tertiary channels, quaternary channels, etc.), until the thermoregulation fluid reaches fine and not very long channels (fine channels or capillary channels) which are located very close to the surface to be thermoregulated. Until here a main channel system has been described acting as “inlet” main channel-system bringing the thermo-regulation fluid all the way to the fine (capillary) channels, the same applies for the “outlet” main channel-system bringing the thermo-regulation fluid away from the fine (capillary) channels, although different configurations of main (primary/secondary/tertiary/quaternary/ . . . ) channel-systems might be used for the “inlet” until the fine (capillary) channels and the “outlet” main channel-system from them. For the sake of minimizing extension of this document only configurations of “inlet” main (primary/secondary/tertiary/quaternary/ . . . ) channel-systems will be provided knowing that they apply to both “inlet” and “outlet” channel system configurations where, as mentioned, the “inlet” main channel-system might have one of the main (primary/secondary/tertiary/quaternary/ . . . ) channel-systems described and the “outlet” main channel-system might have another [as can be seen in one of the examples the configuration of main channel-system (primary/secondary/tertiary/quaternary/ . . . ) refers to either the “inlet” or the “outlet” although both might have the same configuration, for example an “inlet”-system with just one main channel and an “outlet”-system with 12 main channels or a configuration where both the “inlet”-system and the “outlet”-system have just one main channel]. Although in many applications the thermoregulation fluid used may be water, an aqueous solution, an aqueous suspension or any other fluid can also be used in some embodiments. For a given application, finite elements simulation can be used to obtain the most advantageous configuration of the channels. In an embodiment, the system is optimized using finite elements simulation. In an embodiment, the design of the thermoregulation system comprises the use of finite elements simulation (the simulation can be used to select the cross section of the channels, the length, the position, the flow, the fluid, the pressure, etc.). As compared with traditional systems, a peculiarity of the proposed system is that the entrance and the exit of the thermoregulation fluid into the component is made through different channels that are mainly connected with channels of rather smaller individual cross-sections. In an embodiment, the entrance and the exit of the fluid is made through different channels which are located inside the component. In some applications, the thermoregulation fluid enters the component through a main channel (or several main channels), then the thermoregulation fluid is divided into secondary channels which in turn are connected to fine channels. In an embodiment, the main channel is the inlet channel. In some applications, the number of main channels may be important. In some applications, the component comprises more than one main channel. In different embodiments, the component comprises at least 2 main channels, at least 4 main channels, at least 5 main channels, at least 8 main channels, at least 11 main channels and even at least 16 main channels. In some applications, the number of main channels should be not too high. In different embodiments, the component comprises less than 39 main channels, less than 29 main channels, less than 24 main channels, less than 19, main channels and even less than 9 main channels. In an embodiment, the main channels (or main inlet channels) comprise several branches. In some applications, the number of branches may be important. In some applications, the main channels (or main inlet channels) comprise several branches. In different embodiments, the main channels comprise 2 or more branches, 3 or more branches, 4 or more branches, 6 or more branches, 12 or more branches, 22 or more branches and even 110 or more branches. In contrast, in some applications, an excessive division is rather detrimental. In different embodiments, the main channels comprise 280 or less branches, 88 or less branches, 18 or less branches, 8 or less branches, 4 or less branches, and even 3 or less branches. In an embodiment, the branches are located at the outlet of the main channels. In some applications, the cross-section of the main channels may be important. In different embodiments, the cross-section of the main channels is at least 3 times higher, at least 6 times higher, at least 11 times higher and even at least 110 times higher than the cross-section of the smallest channel among all the channels in the component area where the thermoregulation is desired. In an embodiment, the smallest channel among all the fine channels is the fine channel with the smallest cross-section. In an embodiment, there is only one main channel. In some embodiments, there may be more than one main channel. In some applications, the diameter of the main channels may be important. In different embodiments, the diameter of the main channels is 348 mm or less, 294 mm or less, 244 mm or less, 194 mm or less and even 144 mm or less. For some applications, the diameter of the main channels should not be too small. In different embodiments, the diameter of the main channels is 11 mm or more, 21 mm or more, 57 mm or more and even 111 mm or more. In different embodiments, the diameter of all the main channels is 348 mm or less, 294 mm or less, 244 mm or less, 194 mm or less and even 144 mm or less. For some applications, the diameter of the main channels should not be too small. In different embodiments, the diameter of all the main channels is 11 mm or more, 21 mm or more, 57 mm or more and even 111 mm or more. In an embodiment, the diameter is the mean diameter. In an alternative embodiment, the diameter is the equivalent diameter. In an embodiment, the equivalent diameter is the diameter of a circle of equivalent area. In an alternative embodiment, the equivalent diameter is the diameter of a sphere of equivalent volume. In another alternative embodiment, the equivalent diameter is the diameter of a cylinder of equivalent volume. In an embodiment, when the main channels have different diameters, the diameter is the mean diameter of all channels. In some applications, the cross-section of the main channels may be important. In an embodiment, the cross-section of the main channels is at least 3 times higher, at least 6 times higher, at least 11 times higher and even at least 110 times higher than the cross-section of the smallest channel among all the fine channels. For some applications, it is desirable to have main channels with a small cross section. In different embodiments, the cross-section of the main channels is 95115 mm² or less, 2550 mm² or less, 2041.8 mm² or less, 1661.1 mm² or less, 1194 mm² or less, 572.3 mm² or less, 283.4 mm² or less and even 213.0 mm² or less. For some application even smallest cross-sections are preferred. In different embodiments, the cross-section of the main channels is 149 mm² or less, 108 mm² or less, 42 mm² or less, 37 mm² or less, 31 mm² or less, 28 mm² or less, 21 mm² or less and even 14 mm² or less. For some applications, the cross-section of the main channels should not be too small to minimize the pressure drop. In different embodiments, the cross-section of the main channels is 3.8 mm² or more, 9 mm² or more, 14 mm² or more, 21 mm² or more and even 38 mm² or more. In some applications, even main channels with larger cross-sections are preferred. In different embodiments, the cross-section of the main channels is 126 mm² or more, 206 mm² or more, 306 mm² or more and even 406 mm² or more. In an embodiment, the cross-section of the main channels is circular. In alternative embodiments, the cross-section of the main channels may be squared, rectangular, oval, inverse water droplet shape, and/or semicircular. In another alternative embodiment, the cross-section of the main channels may be squared or rectangular with the edges chamfered or rounded. In an embodiment, the profile of the main channels is cylindrical. In an embodiment, the profile of the main channels is elliptical. In an embodiment, the profile of the main channels is cylindrical. In an embodiment, the profile of the main channels is squared with rounded edges. In an embodiment, the profile of the main channels is an inverse droplet. In an embodiment, the cross-section of the main channels is constant. In an alternative embodiment, the main channels do not have a constant cross-section. In an embodiment, when the cross-section of the main channels is not constant, the above disclosed values refer to the minimum cross-section of the main channels. In an alternative embodiment, when the cross-section of the main channels is not constant, the above disclosed values refer to the mean cross-section of the main channels. In another alternative embodiment, when the cross-section of the main channels is not constant, the above disclosed values refer to the maximum cross-section of the main channels. In an embodiment, the cross-section refers to the cross sectional area. In an embodiment, the main channels are the inlet channels. In another embodiment, the main channels are the outlet channels. In some applications, the main channels are connected to more than one secondary channel. In different embodiments, the main channels are connected to 2 or more, to 3 or more, to 4 or more, to 6 or more, to 12 or more, to 22 or more and even to 110 or more secondary channels. The inventor has found that in some applications an excessive number of secondary channels connected to a main channel may be detrimental. In different embodiments, the main channels are connected to 280 or less, to 88 or less, to 18 or less, to 8 or less, to 4 or less and even to 3 or less secondary channels. In different embodiments, the component comprises at least one main channel connected to 2 or more, to 3 or more, to 4 or more, to 6 or more, to 12 or more, to 22 or more and even to 110 or more secondary channels. The inventor has found that in some applications an excessive division may be detrimental. In different embodiments, the component comprises at least one main channel connected to 280 or less, to 88 or less, to 18 or less, to 8 or less, to 4 or less and even to 3 or less secondary channels. In different embodiments, the cross-section of the secondary channels is less than 122.3 mm², less than 82.1 mm², less than 68.4 mm², less than 43.1 mm², less than 26.4 mm², less than 23.2 mm² and even less than 18.3 mm². In some application, even smaller cross-sections are preferred. In different embodiments, the cross-section of the secondary channels is less than 14.1 mm², less than 11.2 mm², less than 9.3 mm², less than 7.8 mm², less than 7.2 mm², less than 6.4 mm², less than 5.8 mm², less than 5.2 mm², less than 4.8 mm², less than 4.2 mm² and even less than 3.8 mm². In some applications, the cross-section of the secondary channels should not be too small. In different embodiments, the cross-section of the secondary channels is 0.18 mm² or more, 3.8 mm² or more, 5.3 mm² or more and even 6.6 mm² or more. In some applications, even larger cross-sections are preferred. In different embodiments, the cross-section of the secondary channels is 18.4 mm² or more, 26 mm² or more, 42 mm² or more and even 66 mm² or more. In an embodiment, the cross-section of the secondary channels is circular. In alternative embodiments, the cross-section of the secondary channels may be squared, rectangular, oval, inverse water droplet shape, and/or semicircular. In another alternative embodiment, the cross-section of the secondary channels may be squared or rectangular with the edges chamfered or rounded. In an embodiment, the profile of the secondary channels is cylindrical. In an embodiment, the profile of the secondary channels is elliptical. In an embodiment, the profile of the secondary channels is cylindrical. In an embodiment, the profile of the secondary channels is squared with rounded edges. In an embodiment, the profile of the secondary channels is an inverse droplet. In an embodiment, the cross-section of the secondary channels is constant. In an alternative embodiment, the secondary channels do not have a constant cross-section. In an embodiment, the secondary channels have a minimum cross-section and a maximum cross-section. In an embodiment, when the cross-section of the secondary channels is not constant, the above disclosed values refer to the minimum cross-section of the secondary channels. In an alternative embodiment, when the cross-section of the secondary channels is not constant, the above disclosed values refer to the mean cross-section of the secondary channels. In another alternative embodiment, when the cross-section of the secondary channels is not constant, the above disclosed values refer to the maximum cross-section of the secondary channels. In different embodiments, the cross-section of the secondary channels is less than 1.4 times, less than 0.9 times, less than 0.7 times, less than 0.5 times and even less than 0.18 times the equivalent diameter. As previously disclosed, the secondary channels may have several divisions (tertiary channels, quaternary channels, . . . ). In an embodiment, the secondary channels are connected to fine channels. In different embodiments, the secondary channels are connected to 2 or more, to 3 or more, to 4 or more, to 6 or more, to 12 or more, to 22 or more, to 110 or more to 310 or more and even to 510 or more fine channels. In contrast, for other applications, an excessive division of the secondary channels may be detrimental. In different embodiments, the secondary channels are connected to 4900 or less, to 680 or less, to 390 or less, to 140 or less, to 90 or less, to 48 or less and even to 2 or less. In different embodiments, the component comprises at least one secondary channel connected to 2 or more, to 3 or more, to 4 or more, to 6 or more, to 12 or more, to 22 or more, to 110 or more, to 310 or more and even to 510 or more fine channels. In contrast, for other applications, an excessive division may be detrimental. In different embodiments, the component comprises at least one secondary channel connected to 4900 or less, to 680 or less, to 390 or less, to 140 or less, to 90 or less, to 48 or less and even to 2 or less fine channels. In an embodiment, the sum of the minimum cross-sections of all the fine channels connected to a secondary channel should be equal to the cross-section of the secondary channel to which are connected. In an alternative embodiment, the sum of the maximum cross-sections of all the fine channels connected to a secondary channel should be equal to the cross-section of the secondary channel to which are connected. In another embodiment, the sum of the minimum cross-sections of all the fine channels connected to a secondary channel is at least 1.2 times bigger than the cross-section of the secondary channel to which are connected. In another embodiment, the sum of the maximum cross-sections of all the fine channels connected to a secondary channel is bigger than the cross-section of the secondary channel to which are connected. In another embodiment, the sum of the maximum cross-sections of all the fine channels connected to a secondary channel is at least 1.2 times bigger than the cross-section of the secondary channel to which are connected. In an embodiment, the cross-section refers to the cross sectional area. In an embodiment, there are no secondary channels. In an embodiment, there are no secondary channels and the main channels are directly connected to the fine channels. In an embodiment, the main channels are directly connected to the fine channels. In an alternative embodiment, there are no main channels. In another alternative embodiment, the component comprises only fine channels. In an embodiment, the cross-section of the fine channels is circular. In alternative embodiments, the cross-section of the fine channels may be squared, rectangular, oval, inverse water droplet shape, and/or semicircular. In another alternative embodiment, the cross-section of the fine channels may be squared or rectangular with the edges chamfered or rounded. In an embodiment, the profile of the fine channels is cylindrical. In an embodiment, the profile of the fine channels is elliptical. In an embodiment, the profile of the fine channels is cylindrical. In an embodiment, the profile of the fine channels is squared with rounded edges. In an embodiment, the profile of the fine channels is an inverse droplet. In an embodiment, the cross-section of the fine channels is constant. In an alternative embodiment, the fine channels do not have a constant cross-section. As previously disclosed, in some applications, it is desirable to have fine channels close to the thermoregulation surface and close among them to achieve the desired homogeneous heat exchange. In an embodiment, the fine channels are the channels that are located in the areas of the component where the thermoregulation is desired. In applications with high mechanical solicitations, fine channels with a small cross-section are preferred. The pressure drop increases when the channels have a small cross section, therefore, in some applications not too long channels are preferred. In different embodiments, the length of the fine channels is 1.8 m or less, 450 mm or less, 180 mm or less, 98 mm or less, 84 mm or less and even 70 mm or less. In some applications, even shorter fine channels are preferred. In different embodiments, the length of the fine channels is 48 mm or less, 39 mm or less, 18 mm or less, 8 mm or less, 4.8 mm or less, 1.8 mm or less and even 0.8 mm or less. In some applications, the length of the fine channels should not be too short. In different embodiments, the length of the fine channels is 0.6 mm or more, 1.2 mm or more, 6 mm or more, 12 mm or more, 16 mm or more, 21 mm or more, 32 mm or more, 41 mm or more, 52 mm or more, 61 mm or more and even 110 mm or more. In an embodiment, the length of the fine channels refers to the mean length of the fine channels. In an alternative embodiment, the length of the fine channels refers to the length of the fine channels in the section under the active surface where an efficient thermoregulation is desired. In another alternative embodiment, the length of the fine channels refers to the minimum length of the fine channels in the section under the active surface where an efficient thermoregulation is desired. In another alternative embodiment, the length of the fine channels refers to the length of the section under the active surface where an efficient thermoregulation is desired, not accounting the section of the channels that carries the thermoregulation fluid from the secondary channels, eventually also from the main channels, to the section wherein the heat exchange with the active surface is efficient. In another alternative embodiment, the length of the fine channels refers to the total length of the fine channels. In some applications, a component with a high density of fine channels under the active surface is preferred. In an embodiment, the surface density of fine channels is evaluated in the surface area to be thermo-regulated. When the fine channels are projected onto the surface area to be thermo-regulated, as a result the projection of the maximum cross section of each fine channel is obtained. The surface density of fine channels is calculated as the surface occupied by the fine channels projection/the total surface to be thermo-regulated. In an embodiment, the thermo-regulated area comprises at least an area with the right surface density of fine channels (in that case the surface density of fine channels is calculated as the surface occupied by the fine channels projection/the minimum area in the surface to be thermo-regulated that comprises the projection of the fine channels). In an embodiment, the surface density of fine channels is calculated as the surface occupied by the fine channels projection/the minimum area in the surface to be thermo-regulated that comprises the projection of the fine channels. In different embodiments, the right surface density of fine channels is 12% or more, 27% or more, 42% or more and even 52% or more. Other applications require a more intense and homogeneous heat exchange. In different embodiments, the right surface density of fine channels is 62% or more, 72% or more, 77% or more and even 86% or more. In some applications, an excessive surface density of fine channels can lead to mechanical failure of the component among other problems. In different embodiments, the right surface density of fine channels is 57% or less, 47% or less, 23% or less and even 14% or less. The inventor has found that in some applications, the important thing is to control the ratio H, where H=the total length of the fine channels (the sum of the lengths of all the fine channels)/the mean length of the fine channels. In different embodiments, the preferred H ratio is greater than 12, greater than 110, greater than 1100 and even greater than 11000. In some applications, an excessive H ratio may be detrimental. In different embodiments, the H ratio is less than 1098, less than 998, less than 900, less than 230, less than 90 and even less than 45. In some applications, the number of fine channels per square meter of the surface of the component should not be too low. In different embodiments, the preferred number of fine channels is 21 fine channels per square meter or more, 46 fine channels per square meter or more, 61 fine channels per square meter or more and even 86 fine channels per square meter or more. In some applications, higher values are preferred. In different embodiments, the number of fine channels is 110 fine channels per square meter or more, 1100 fine channels per square meter or more, 11000 fine channels per square meter or more and even 52000 fine channels per square meter or more. In some applications, the number of fine channels by surface area should not be too high. In different embodiments, the number of fine channels is 14000 fine channels per square meter or loss, 9000 fine channels per square meter or less, 4000 fine channels per square meter or less and even 1600 fine channels per square meter or less. In some applications, even lower values are preferred. In different embodiments, the number of fine channels is 1200 fine channels per square meter or less, 900 fine channels per square meter or less, 400 fine channels per square meter or less and even 94 fine channels per square meter or less. In an embodiment, the surface of the component refers to the surface to be thermo-regulated. In an embodiment, the surface of the component refers to the active surface. In an alternative embodiment, the surface of the component refers to the working surface. When it comes to the thermoregulation systems, particularly when the thermoregulation is performed with fluid assistance, an important advantage of the thermoregulation systems proposed is the homogeneous distribution of the thermoregulatory fluid very close to the surface of the component to be thermo-regulated. In some applications, the distance of the fine channels to the surface of the component may be important. In different embodiments, the distance of the fine channels to the surface is 32 mm or less, 18 mm or less, 8 mm or less, 4.8 mm or less, 1.8 mm or less and even 0.8 mm or less. In some applications, a too small distance may be counterproductive. In different embodiments, the mean distance of the fine channels to the surface is 0.6 mm or more, 1.2 mm or more, 6 mm or more and even 16 mm or more. In an embodiment, the distance of the fine channels to the surface is the mean distance among all the distances to the surface of every singular fine channel. In an alternative embodiment, the distance of the fine channels to the surface is the minimum distance among all the distances to the surface of every singular fine channel. In an embodiment, the distance of the fine channels to the surface is the maximum distance among all the distances to the surface of every singular fine channel. In an embodiment, the surface refers to the surface area to be thermo-regulated. In an embodiment, the distance of a singular fine channel to the surface is the minimum distance of any point in that channel to a point in the surface area to be thermo-regulated. In an alternative embodiment, the distance of a singular fine channel to the surface is calculated in the following fashion: for every plane which is simultaneously orthogonal to the surface area to be thermo-regulated and the vector of the maximum speed of the fluid circulating in the fine channel, the minimum distance to the surface to be thermo-regulated of any point in that plane belonging to the fine channel is considered, the mean value of all considered distances is taken. In an alternative embodiment, the distance of a singular fine channel to the surface is calculated in the following fashion: for every plane which is simultaneously orthogonal to the surface area to be thermo-regulated and the vector of the maximum speed of the fluid circulating in the fine channel, the minimum distance to the surface to be thermo-regulated of any point in that plane belonging to the fine channel is considered, the maximum value of all considered distances is taken. In an alternative embodiment, the distance of a singular fine channel to the surface is calculated in the following fashion: for every plane which is simultaneously orthogonal to the surface area to be thermo-regulated and the vector of the maximum speed of the fluid circulating in the fine channel, the distance from the point of maximum speed to the surface to be thermo-regulated of any point in that plane belonging to the fine channel is considered, the mean value of all considered distances is taken. In some applications, fine channels close to each other are preferred, therefore the distance between the fine channels should not be excessive. In different embodiments, the fine channels are separated from each other a distance of 18 mm or less, 9 mm or less, 4.5 mm or less and ever 1.8 mm or loss. In some applications, the distance between the fine channels should not be too small. In different embodiments, the fine channels are separated from each other a distance of 0.2 mm or more, 0.9 mm or more, 1.2 mm or more, 2.6 mm or more, 6 mm or more, 12 mm or more and even 22 mm or more. In an embodiment, the distance is the mean distance. In an alternative embodiment, the distance is the minimum distance. In another alternative embodiment, the distance is the maximum distance. In some applications, the diameter of the fine channels may be important. In some applications, the diameter of the fine channels should not be too large. In different embodiments, the diameter of the fine channels is 128 mm or less, 38 mm or less, 18 mm or less, 8 mm or less, 2.8 mm or less and even 0.8 or less. In some applications, the diameter of the fine channels should not be too small. In different embodiments, the diameter of the fine channels is 0.1 mm or more, 0.6 mm or more, 1.2 mm or more, 6 mm or more, 12 mm or more and even 22 mm or more. In some applications, even higher values are preferred. In different embodiments, the diameter of the fine channels is 56 mm or more and even 108 mm or more. In an embodiment, the diameter is the mean diameter. In an alternative embodiment, the diameter is the minimum diameter. In another alternative embodiment, the diameter is the maximum diameter. In another alternative embodiment, the diameter is the equivalent diameter. In another alternative embodiment, the diameter is the mean equivalent diameter. In an embodiment, the equivalent diameter is the diameter of a circle of equivalent area. In an alternative embodiment, the equivalent diameter is the diameter of a sphere of equivalent volume. In another alternative embodiment, the equivalent diameter is the diameter of a cylinder of equivalent volume. In some applications, the cross-section of the fine channels may be important. In some applications, the cross-section of the fine channels should not be too large. In different embodiments, the cross-section of the fine channels is 12868 mm² or less, 3900 mm² or less, 1134 mm² or less, 255 mm² or less, 50 mm² or less, 6.2 mm² or less and even 5 mm² or less. In some applications, the cross-section of the fine channels should not be too small. In different embodiments, the cross-section of the fine channels is 0.008 mm² or more, 0.28 mm² or more, 1.13 mm² or more, 310 mm² or more, 1100 mm² or more, 2500 mm² or more and even 9100 mm² or more. In alternative embodiments, the cross-section of the fine channels may be circular, squared, rectangular, oval, inverse water droplet shape, and/or semicircular. In another alternative embodiment, the cross-section of the fine channels may be squared or rectangular with the edges chamfered or rounded. In an embodiment, the cross-section of the fine channels is constant. In an alternative embodiment, the fine channels do not have a constant cross-section. In an embodiment, when the cross-section of the fine channels is not constant, the above disclosed values refer to the minimum cross-section of the fine channels. In an alternative embodiment, when the cross-section of the fine channels is not constant, the above disclosed values refer to the mean cross-section of the fine channels. In another alternative embodiment, when the cross-section of the fine channels is not constant, the above disclosed values refer to the maximum cross-section of the fine channels. In an embodiment, the cross-section refers to the cross sectional area. In thermoregulation systems where the components are subjected to important mechanical solicitations, there is always a dilemma between the proximity and the cross section of the channels. If the cross section of the channels is small, then the pressure drop increases and the heat exchange capacity is reduced. In some applications, the total pressure drop may be important. It has been found that in some applications, the total pressure drop in the thermoregulation system should not be too high. In different embodiments, the total pressure drop in the thermoregulation system is less than 7.9 bar, less than 3.8 bar, less than 2.4 bar, less than 1.8 bar, less than 0.8 bar and even less than 0.3 bar. In some applications, the total pressure drop in the thermoregulation system should not be too low. In different embodiments, the total pressure drop in the thermoregulation system is at least 0.01 bar, at least 0.1 bar, at least 0.6 bar, at least 1.6 bar, at least 2.1 bar and even at least 3.1 bar. In some applications, the pressure drop in the fine channels may be important. In some applications, the pressure drop in the fine channels should not be too high. In different embodiments, the pressure drop in the fine channels is less than 5.9 bar, less than 2.8 bar, less than 1.4 bar, less than 0.8 bar, less than 0.5 bar and even less than 0.1 bar. In some applications, the total pressure drop in the fine channels should not be too low. In different embodiments, the total pressure drop in the fine channels is at least 0.01 bar, at least 0.09 bar, at least 0.2 bar, at least 0.6 bar, at least 1.1 bar and even at least 2.1 bar. In an embodiment, the pressure drop is at room temperature (23° C.). In some applications, the rugosity (Ra) within the channels is very important and may be used to describe the flow. In some applications, the Ra should not be too high. In different embodiments, the Ra is less than 198 microns, less than 98 microns, less than 49.6 microns, less than 18.7 microns, less than 9.7 microns, less than 4.6 microns and even less than 1.3 microns. In different embodiments, the Ra is at least 0.2 microns, at least 0.9 microns, at least 1.6 microns, at least 2.1 microns, at least 10.2 microns, at least 22 microns and even at least 42 microns. In some of those applications, it is interesting to have the so-called Slippery effect on the channels. In an embodiment, the rugosity of the channels is intentionally increased and then the channels are impregnated with an oil. In an embodiment, the oil employed for impregnation is a fluorated oil. In an embodiment, the rugosity in the channels is increased by circulating an aggressive fluid through them. In an embodiment, the aggressive fluid comprises an acid. In some applications, the Reynolds number (describes the degree of laminar or turbulent flow) may be important. In an embodiment, the inlet pressure, the length of the fine channels and the cross-section of the fine channels are chosen so that the mean Reynolds number in the fine channels is the right Reynolds number (as defined below). In an embodiment, the inlet pressure, the length of the fine channels and the cross-section of the fine channels are chosen so that the minimum Reynolds number in the fine channels is the right Reynolds number (as defined below). In an embodiment, the inlet pressure, the length of the main channels, the cross-section of the main channels, the length of the secondary channels, the cross-section of the secondary channels, the length of the fine channels and the cross-section of the fine channels are chosen so that the mean Reynolds number in the fine channels is the right Reynolds number (as defined below). In an embodiment, the inlet pressure, the length of the main channels, the cross-section of the main channels, the length of the secondary channels, the cross-section of the secondary channels, the length of the fine channels and the cross-section of the fine channels are chosen so that the minimum Reynolds number in the fine channels is the right Reynolds number (as defined below). In an embodiment, the inlet pressure and the configuration of the thermoregulatory channels are selected so that according to simulation, the mean Reynolds number is the right Reynolds number (as defined below). In an embodiment, the inlet pressure and the configuration of the thermoregulatory channels are selected so that according to simulation, the minimum Reynolds number is the right Reynolds number (as defined below). In an embodiment, the fluid flows in the channels in such a way that the Reynolds number is the right Reynolds number. Unless otherwise stated, the feature “right Reynolds number” is defined throughout the present document in the form of different alternatives that are explained in detail below. In different embodiments, the right Reynolds number is greater than 810, greater than 2800, greater than 4200, greater than 8800, greater than 12000, and even greater than 22000. In some applications, lower values are preferred. In different embodiments, the right Reynolds number is less than 89000, less than 26000, less than 14000, less than 4900, and even less than 3400. In some applications, the speed of the fluid in the channels may be important. For some applications, a high speed can help thermoregulation. In different embodiments, the mean speed of the fluid is greater than 0.7 m/s, greater than 1.6 m/s, greater than 2.2 m/s, greater than 3.5 m/s and even greater than 5.6 m/s. For some applications, a very high speed may be detrimental. In different embodiments, the mean speed of the fluid is less than 14 m/s, less than 9 m/s, less than 4.9 m/s, and even less than 3.9 m/s. All the embodiments disclosed above can be combined among them and with any other embodiment disclosed in this document in any combination, provided that they are not mutually exclusive.

For some applications, it has been found that the configuration that is explained below is very advantageous and allows for improved heat exchange and more effective tempering of the manufactured component. In this configuration, at least some of the main/secondary channels (there may be different levels of secondary channels, this means, tertiary channels, quaternary channels, etc.) are used as collectors and at least some of the fine channels are disposed between 2 of such collectors. In an embodiment, the manufactured component comprises at least one “inlet” collector and one “outlet” collector connected by more than one fine channel. The collectors are characterized by a rather homogeneous temperature within them, but with a noticeable thermal gradient between an “inlet” collector and one of its corresponding “outlet” collectors. In an embodiment, the “inlet” collector comprises at least one main/secondary channel. In an embodiment, the “inlet” collector comprises at least one main/secondary channel. In an embodiment, there are several fine channels connecting the “inlet” and the “outlet” collector. In different embodiments, there are at least 2 or more, 3 or more, 4 or more, 6 or more, 12 or more, 22 or more, 110 or more, 310 or more and even 510 or more fine channels connecting the “inlet” and the “outlet” collector. For certain applications, an excessive number of fine channels may be detrimental. In different embodiments, there are 4900 or less, 680 or less, 390 or less, 140 or less, 90 or less, 48 or less, and even 2 or less fine channels connecting the “inlet” and the “outlet” collector. In an embodiment, there is more than one “inlet” and/or “outlet” collector with their fine channels connecting them. In different embodiments, the temperature gradient within the collector (“inlet” collector and/or “outlet” collector) is below 39° C., below 9° C., below 4° C., below 0.9° C., below 0.4° C. and even below 0.09° C. In an embodiment, the temperature gradient is calculated using the mean temperature corresponding to the insertion section of the fine channels into the main/secondary channels which are part of the collector. In different embodiments, the temperature gradient of the collector is calculated with 12%, 20%, 50%, 80% and even 100% of the insertion sections that lead to a minimum gradient within the collector. In some applications, it has been found that the placement of the fine channels as well as their configuration and the configuration of the main “inlet” and “outlet” channel-systems and the thermo-regulation fluid nature and its temperature play an important role in the thermo-regulation efficiency of the component, optimized configurations can be chosen through the knowledge of an expert and also through simulation with even lesser effort. The inventor has found that surprisingly the effort can be further reduced to determine whether a configuration complies with the present aspect of the present invention by just monitoring or simulating the temperatures of the collectors at the insertion points for a relevant fraction of the fine (capillary) channels.

In an embodiment, the tempering circuit is characterized by having a relevant fraction of the fine channels connecting two collectors presenting a temperature gradient of 0.2° C. or more between their two insertion points with each collector (when not otherwise indicated, in the case the fine channel has more than two insertion points to collectors, the two insertion points leading to a higher gradient are chosen). In different embodiments, the temperature gradient between the two insertion points of the fine channels to the collectors, for a relevant fraction of fine channels, is more than 1.1° C., 2.6° C., 4.2° C., 8.2° C., 11° C., 22° C. and even 52° C. In most several applications it is important to not have an excessive gradient. In different embodiments, the temperature gradient between the two insertion points of the fine channels to the collectors, for a relevant fraction of fine channels, is less than 199° C., 94° C., 48° C., 24° C., 14° C., 8° C. and even 1.8° C. In several applications it is important to have the right gradient. In an embodiment, the tempering circuit is characterized by having a relevant fraction of the fine channels connecting two collectors presenting a temperature gradient within an upper and lower limit. In different embodiments, a relevant fraction of the fine channels means the 12%, 20%, 50%, 80% and even 100% of the fine channels whose temperature gradients between their two insertion points are greater (percentages are rounded to a whole fine channel number). All the embodiments disclosed above can be combined among them and with any other embodiment disclosed in this document in any combination, provided that they are not mutually exclusive.

In an embodiment, the manufactured component comprises channels that are connected to the surface of the component, to carry a liquid to the surface of the component (through a hole in the surface of the component). In some applications it is particularly interesting the use of the heat of vaporization. The inventor has found that in order to achieve the controlled thermoregulation effectively, the distance of the channels that carry the liquid to the surface of the component should not be too large. In different embodiments, the distance of the channels that carry the liquid to the surface of the component is less than 19 mm, less than 14 mm, less than 9 mm, less than 4 mm, less than 2 mm, less than 1.5 mm, less than 1 mm and even less than 0.9 mm. In some applications the distance should not be too short. In different embodiments, the distance of the channels that carry the liquid to the surface of the component is 0.6 mm or more, 0.9 mm or more, 1.6 mm or more, 2.6 mm or more, 4.6 mm or more, 6.1 mm or more and even 10.2 mm or more. In different embodiments, the diameter of the holes in the surface of the component is less than 1 mm, less than 490 microns, less than 290 microns, less than 190 microns and even less than 90 microns. In some applications the diameter should not be too small. In different embodiments, the diameter of the holes in the surface of the component is 2 microns or more, 12 microns or more, 52 microns or more, 102 microns or more and even 202 microns or more. The inventor has also found that an advantageous way to perform the holes in the surface of the component is through a laser cutting method and any other method like electro discharge machining (EDM). In an embodiment, the holes are made by electro discharge machining (EDM). In another embodiment, the holes are made using a laser. In an embodiment, the holes are made by laser drilling. In an embodiment, the laser drilling technique is single pulse drilling. In another embodiment, the laser drilling technique is percussion drilling. In another embodiment, the laser drilling technique is trepanning. In another embodiment, the laser drilling technique is helical drilling. In an alternative embodiment, the holes are made by electro discharge machining (EDM). In different embodiments, the length of the holes in the surface of the component is less than 19 mm, less than 9 mm and even less than 4 mm. In some applications the length should not be too short. In different embodiments, the length of the holes in the surface of the component is 0.1 mm or more, 0.6 mm or more, 1.1 mm or more, 1.6 mm or more, 2.1 mm or more and even 4.1 mm or more. In different embodiments, the diameter of the channels that carry the liquid to the surface of the component is less than 19 mm, less than 9 mm and even less than 4 mm. In some applications the diameter should not be too small. In different embodiments, the diameter of the channels that carry the liquid to the surface of the component is 0.6 mm or more, 1.1 mm or more, 2.1 mm or more, 4.1 mm or more and even 6.2 mm or more. All the embodiments disclosed above can be combined among them and with any other embodiment disclosed in this document in any combination, provided that they are not mutually exclusive.

In some embodiments, the entire component is manufactured applying the proper geometrical design strategy disclosed in the preceding paragraphs. In other embodiments, only part of the component is manufactured applying the proper geometrical design strategy disclosed in the preceding paragraphs. In some embodiments, when only part of the component is manufactured, the above disclosed for the component applies at least to the part of the component manufactured applying the proper geometrical design strategy.

The “proper geometrical design strategy” disclosed in the preceding paragraphs can be applied to the design of components manufactured according to the methods and/or the compositions disclosed in this document, but also can be applied to other methods and compositions and thus might constitute an invention on their own. All the embodiments disclosed above can be combined among them and with any other embodiment disclosed in this document in any combination, provided that they are not mutually exclusive.

In the several years of work leading to the present invention, the inventor has realized that very unexpected results can be attained with particular combinations of different nature powders in terms of composition and morphology. Although most such observations were made while trying to develop the methods of the present invention, many are also extendible to other manufacturing methods surprisingly enough to several additive manufacturing methods. Most of those observations are somewhat related but the inventor has not found an easily understandable way to synthetize nor classify them and has opted to list them with no particular order.

Some MAM (Metal Additive Manufacturing) methods try to avoid the high energy involved in the melting of metals and bond small particles of metal selectively often by means of a polymeric material acting as a glue. Also, the method of the present invention capitalizes the much lower energy involved in the additive manufacturing of polymers or elastomers when compared to metals. Many of those MAM methods using a binder material struggle when dealing with large components made of metals with high melting temperature (and even more so when they also have high density). That is so, amongst others, because the large components, and even more so when the material has a medium or high density, suffer a significant loading just through their own weight. While finding binding systems that can provide sufficient strength to withstand the own weight of very large components, most of the binding agents employed lose their strength at rather low temperatures (below 500° C.) and when dealing with a high melting point metal, sintering will not start at such low temperatures. So, there is a gap of temperatures between debinding and sintering of the components where the strength is only provided by the interlocking of particles. Traditionally the way of enhancing interlocking has been to use irregular particles or very small spherical particles, but both present a low filling density leading to very difficult to predict distortions and are also associated to low performance due amongst others to their propensity to readily oxidize (the reason why they improve interlocking is the higher amount of surface per unit weight, but the same relevant surface for the interlocking is relevant surface for the oxidation). When mixing irregular with spherical particles, the fill density and associated distortions are improved but the interlocking is no longer as good and the mechanical properties tend to severely deteriorate. In the case, of trying to achieve high performant, yet large components the paradox related to the surface amount per unit weight is encountered. The inventor has found that proceeding in a particular way which consists in very carefully choosing the nature and morphology as well as fractions of more than one powder type can surprisingly dismantle the paradox. Each one of the systems described in this document is independent of the rest, and the effects encountered in each case cannot be extrapolated to the other cases, nonetheless the inventor has tried to formulate some generalizations knowingly that they only account for a small portion of the surprising effects encountered in the particular systems described (even when leading just with the interlocking effects). The inventor has found that the paradox introduced can be partially resolved for applications of medium to high performance by the mixture of at least two powders. In the case of high to very high performance applications, three or more powders are required. For certain applications, the use of a powder is also advantageous. To the knowledge of the inventor not such strategies of mixtures have been described in the literature, so he claims a powder mixture capable of high interlocking and high performance comprising at least two different nature powders. Unless otherwise stated, the feature “mixing strategy” is defined throughout the present document in the form of different alternatives that are explained in detail below. In an embodiment, the powder mixture comprises at least two different nature powders. In an embodiment, different nature powders means powders with different composition. In another embodiment, different nature powders means powders with different morphology. In another embodiment, different nature powders means powders with different size. In another embodiment, different nature powders means powders with different size and different morphology. In another embodiment, different nature powders means powders with different chemical composition and different size. In another embodiment, different nature powders means powders with different morphology and different chemical composition. In another embodiment, different nature powders means powders with different size, different chemical composition and different morphology. The inventor has found that for some applications, the use of a powder mixture comprising at least two powders in the right proportion to each other, both in the same base but one larger and more irregular than the other is advantageous. In an embodiment, the powder mixture comprises at least two powders in the same base. Being in the same base means that they share the same major element. In an embodiment, the major element is the element with the highest weight percentage in the powder mixture. In an embodiment, the base is Fe. In another embodiment, the base is Ni. In another embodiment, the base is Co. In another embodiment, the base is Zn. In another embodiment, the base is Cu. In another embodiment, the base is Ti. In another embodiment, the base is Mg. In another embodiment, the base is Al. In another embodiment, the base is Cr. In another embodiment, the base is Mo. In another embodiment, the base is W. In another embodiment, the base is Ta. In another embodiment, the base is Zr. In another embodiment, the base is Sn. In another embodiment, the base is Li. In another embodiment, the base is Mn. In another embodiment, the base is Nb. In another embodiment, the base is Si. In some instances, bases can be used with two predominant elements in similar proportions. In an embodiment, the base has two main elements in comparable proportions. In different embodiments, comparable proportions means that the difference in the weight percentage is less than 39 wt %, less than 10 wt %, less than 6 wt % and even less than 3 wt %. In an embodiment, the major element, are the two elements with the highest weight percentages in such powder. In another embodiment, the base has three main elements in comparable proportions. In an embodiment, the major element, are the three elements with the highest weight percentages in such powder. In an embodiment, the base are Fe and Ni. In another embodiment, the base are Fe and Cr. In another embodiment, the base are Fe, Cr and Ni. In another embodiment, the base are Fe and Co. In another embodiment, the base are Fe, Co and Ni. In another embodiment, the base are Fe, Cr and Co. In another embodiment, the base are Cr and Ni. In another embodiment, the base are Cr and Co. In another embodiment, the base are Co and Ni. In another embodiment, the base are Cr, Co and Ni. In another embodiment, the base are Mo and W. In another embodiment, the base are Al and Ni. In another embodiment, the base are Al and Cr. In another embodiment, the base are Al and Mg. In another embodiment, the base are Ti and Ni. In another embodiment, the base are Cu and Ni. In another embodiment, the base are Cu and Al. In another embodiment, the base are Cu and Sn. In another embodiment, the base are Cu and Zn. In another embodiment, the base are Al and Ti. In an embodiment, a mixture of two or more different in chemical composition powders is used. In another embodiment, a mixture of three or more different in chemical composition powders is used. In another embodiment, a mixture of four or more different in chemical composition powders is used. In another embodiment, a mixture of five or more different in chemical composition powders is used. In some applications it might be interesting to have more than one final material in a given component. Several reasons might be the origin of this, like for example having a high thermal conductivity next to lower thermal conductivity materials on the active surfaces of a die for tailored heat extraction, or having a lower cost material away from the critical working zone, or having a very high wear resistance in the high wear areas and a more damage tolerant material in the crack prone areas of the component. This can be achieved in many ways, amongst others by filling the mold in a stratified way with different materials layers. In an embodiment, the final component has several materials. In an embodiment, a given material of the final component is the mixture of powders which has been done prior to filling the mold or part of it or also the mixture that takes place through vibration or other means within the mold. In an embodiment, a given material of the final component is addition of the mixture of powders which has been mixed together prior to filling the mold or part of it. In an embodiment, what has been said about the material of the final component just has to apply to one of the materials of the final component. In an embodiment, what has been said about the material of the final component has to apply to all of the materials of the final component. In an embodiment, what has been said about the material of the final component just has to apply to one or more of the materials of the final component representing a significant portion of the final component. In different embodiments, a significant portion is 2% or more, 16% or more, 36% or more, 56% or more and even 86% or more. In an embodiment, these percentages are by volume (vol %). In an alternative embodiment, these percentages are by weight (wt %). In an embodiment, there are at least two powders mixed together with a significant difference in the content of at least one critical element. In an embodiment, there are at least two powders mixed together with a significant difference in the content of a critical element. In an embodiment, there are at least two powders mixed together with a significant difference in the content of at least two critical elements. In an embodiment, there are at least two powders mixed together with a significant difference in the content of at least three critical elements. In an embodiment, there are at least two powders mixed together with a significant difference in the content of at least four critical elements. In an embodiment, there are at least two powders mixed together with a significant difference in the content of at least five critical elements. In an embodiment, the two powders are mixed together in the same material. In an embodiment, Cr is a critical element. In an embodiment, Mn is a critical element. In an embodiment, Ni is a critical element. In an embodiment, V is a critical element. In an embodiment, Ti is a critical element. In an embodiment, Mo is a critical element. In an embodiment, W is a critical element. In an embodiment, Al is a critical element. In an embodiment, Zr is a critical element. In an embodiment, Si is a critical element. In an embodiment, Sn is a critical element. In an embodiment, Mg is a critical element. In an embodiment, Cu is a critical element. In an embodiment, C is a critical element. In an embodiment, B is a critical element. In an embodiment, N is a critical element. In an embodiment, a significant difference in the content means that the weight content of the critical element in the powder with high content is at least a 50% higher than in the powder with lower content of the critical element (for the purpose of clarity, if the powder with low content of the critical element has 0.8 wt % of the critical element, then the powder with the higher content of the critical element has to have 1.2 wt % or more of the critical element). In an embodiment, a significant difference in the content means that the weight content of the critical element in the powder with high content is at least double as high that in the powder with lower content of the critical element. In another embodiment, a significant difference in the content means that the weight content of the critical element in the powder with high content is at least three times higher than in the powder with lower content of the critical element. In another embodiment, a significant difference in the content means that the weight content of the critical element in the powder with high content is at least four times higher than in the powder with lower content of the critical element. In another embodiment, a significant difference in the content means that the weight content of the critical element in the powder with high content is at least five times higher than in the powder with lower content of the critical element. In another embodiment, a significant difference in the content means that the weight content of the critical element in the powder with high content is at least ten times higher than in the powder with lower content of the critical element. In some applications, it is the content of the critical element in both powders that is important. In some applications, it is the content of the sum of some critical elements in both powders that is important. In an embodiment, at least one of the powders of the mixture has a high enough content of the critical element while in at least another powder within the same mixture has a low enough content. In different embodiments, a high enough content is 0.2 wt % or more, 0.6 wt % or more, 1.2 wt % or more, 3.2 wt % or more, 5.2 wt % or more, 12 wt % or more, 16 wt % or more. In different embodiments, a low enough content is 49 wt % or less, 19 wt % or less, 9 wt % or less, 3.8 wt % or less, 1.9 wt % or less, 0.9 wt % or less and even 0.09 wt % or less. In an embodiment, at least one powder of the mixture has to have a high enough content (in the terms described above) of the sum of % V+% Cr+% Mo+% W+% Ta+% Zr+% Hf while at least another powder of the mixture has to have a low enough content (in the terms described above) of this sum of elements. In an embodiment, at least one powder of the mixture has to have a high enough content (in the terms described above) of the sum of % V+% Cr+% Mo while at least another powder of the mixture has to have a low enough content (in the terms described above) of this sum of elements. In an embodiment, at least one powder of the mixture has to have a high enough content (in the terms described above) of the sum of % Ni+% Cr+% Mn+% Mo while at least another powder of the mixture has to have a low enough content (in the terms described above) of this sum of elements. In an embodiment, at least one powder of the mixture has to have a high enough content (in the terms described above) of the sum of % V+% Al+% Sn while at least another powder of the mixture has to have a low enough content (in the terms described above) of this sum of elements. In an embodiment, at least one powder of the mixture has to have a high enough content (in the terms described above) of the sum of % V+% Al while at least another powder of the mixture has to have a low enough content (in the terms described above) of this sum of elements. In an embodiment, at least one powder of the mixture has to have a high enough content (in the terms described above) of the sum of % Si+% Mn+% Mg+% Zn+% Sc+% Zr while at least another powder of the mixture has to have a low enough content (in the terms described above) of this sum of elements. In an embodiment, at least one powder of the mixture has to have a sufficiently high content (in the terms described below) of the sum of % V+% Cr+% Mo+% W+% Ta+% Zr+% Hf+% Ti while at least another powder of the mixture has to have a sufficiently low content (in the terms described below) of this sum of elements when the final component is mainly iron (in the terms described below). In different embodiments, a sufficiently high content is 0.6 wt % or more, 1.2 wt % or more, 2.6 wt % or more, 4.6 wt % or more and even 10.6 wt % or more. In different embodiments, a sufficiently low content is 36 wt % or less, 9 wt % or less, 4 wt % or less, 2 wt % or less, 0.9 wt % or less and even 0.09 wt % or less. In an embodiment, at least one powder of the mixture has to have a sufficiently high content (in the terms described below) of the sum of % Ni+% Cr+% Mn+% Ti while at least another powder of the mixture has to have a sufficiently low content (in the terms described below) of this sum of elements when the final component is mainly iron (in the terms described below). In different embodiments, a sufficiently high content is 0.6 wt % or more, 6 wt % or more, 12.6 wt % or more, 16 wt % or more and even 26 wt % or more. In different embodiments, a sufficiently low content is 66 wt % or less, 24 wt % or less, 9 wt % or less, 4 wt % or less, 0.9 wt % or less and even 0.09 wt % or less. In an embodiment, at least one powder of the mixture has to have a sufficiently high content (in the terms described below) of the sum of % Al+% Sn+% Cr+% V+% Mo+% Ni+% Pd while at least another powder of the mixture has to have a sufficiently low content (in the terms described below) of this sum of elements when the final component is mainly titanium (in the terms described below). In different embodiments, a sufficiently high content is 0.6 wt % or more, 6 wt % or more, 12.6 wt % or more, 16 wt % or more and even 22 wt % or more. In different embodiments, a sufficiently low content is 39 wt % or less, 19 wt % or less, 9 wt % or less, 4 wt % or less, 0.9 wt % or less and even 0.09 wt % or less. In an embodiment, at least one powder of the mixture has to have a sufficiently high content (in the terms described below) of the sum of % Al+% Sn+% V while at least another powder of the mixture has to have a sufficiently low content (in the terms described below) of this sum of elements when the final component is mainly titanium (in the terms described below). In different embodiments, a sufficiently high content is 0.6 wt % or more, 6 wt % or more, 12.6 wt % or more, 16 wt % or more and even 22 wt % or more. In different embodiments, a sufficiently low content is 39 wt % or less, 19 wt % or less, 9 wt % or less, 4 wt % or less, 0.9 wt % or less and even 0.09 wt % or less. In an embodiment, at least one powder of the mixture has to have a sufficiently high content (in the terms described below) of the sum of % Cu+% Mn+% Mg+% Si while at least another powder of the mixture has to have a sufficiently low content (in the terms described below) of this sum of elements when the final component is mainly aluminium (in the terms described below). In different embodiments, a sufficiently high content is 0.2 wt % or more, 0.6 wt % or more, 1.2 wt % or more, 2.6 wt % or more, 5.2 wt % or more and even 11 wt % or more. In different embodiments, a sufficiently low content is 19 wt % or less, 9 wt % or less, 4 wt % or less, 1.9 wt % or less, 0.9 wt % or less and even 0.09 wt % or less. In an embodiment, at least one powder of the mixture has to have a sufficiently high content (in the terms described below) of the sum of % Cu+% Mn+% Mg+% Si+% Fe+% Zn while at least another powder of the mixture has to have a sufficiently low content (in the terms described below) of this sum of elements when the final component is mainly aluminium (in the terms described below). In different embodiments, a sufficiently high content is 0.2 wt % or more, 0.6 wt % or more, 1.2 wt % or more, 2.6 wt % or more, 5.2 wt % or more and even 11 wt % or more. In an embodiment, a sufficiently low content is 19 wt % or less, 9 wt % or less, 4 wt % or less, 1.9 wt % or less, 0.9 wt % or less and even 0.09 wt % or less. In an embodiment, at least one powder of the mixture has to have a sufficiently high content (in the terms described below) of the sum of % Cr+% Co+% Mo+% Ti while at least another powder of the mixture has to have a sufficiently low content (in the terms described below) of this sum of elements when the final component is mainly nickel (in the terms described below). In different embodiments, a sufficiently high content is 1.2 wt % or more, 16 wt % or more, 22 wt % or more, 32 wt % or more, 36 wt % and even 42 wt % or more. In different embodiments, a sufficiently low content is 65 wt % or less, 29 wt % or less, 14 wt % or less, 9 wt % or less, 0.9 wt % or less and even 0.09 wt % or less. In an embodiment, at least one powder of the mixture has to have a sufficiently high content (in the terms described below) of the sum of % Cr+% Co while at least another powder of the mixture has to have a sufficiently low content (in the terms described below) of this sum of elements when the final component is mainly nickel (in the terms described below). In different embodiments, a sufficiently high content is 1.2 wt % or more, 16 wt % or more, 22 wt % or more, 32 wt % or more, 36 wt % or more and even 42 wt % or more. In different embodiments, a sufficiently low content is 65 wt % or less, 29 wt % or less, 14 wt % or less, 9 wt % or less, 9 wt % or less and even 0.09 wt % or less. In an alternative embodiment, the percentages disclosed above are by volume. In an embodiment, the critical element (or critical element sum) low content powder is not the largest powder. In an embodiment, for a powder to be the largest powder, it should be the powder with the highest D50. In an alternative embodiment, for a powder to be the largest powder, it should be the powder with the highest volume percentage. In another alternative embodiment, for a powder to be the largest powder, it should be the powder with the highest weight percentage. In an embodiment, at least one critical element (or critical element sum) high content powder is considerably bigger in size than at least one of the critical element (or critical element sum) low content powders. In an embodiment, at least one critical element (or critical element sum) high content powder is considerably bigger in size than all of the critical element (or critical element sum) low content powders. In an embodiment, the considerable bigger in size powder with a critical element (or critical element sum) high content is present in a relevant amount (definition of relevant amount can be found below). In an embodiment, a high content is a high enough content (as previously defined). In an alternative embodiment, a high content is a sufficiently high content (as previously defined). In an embodiment, a low content is a low enough content (as previously defined). In an alternative embodiment, a low content is a sufficiently low content (as previously defined). In an embodiment, considerably bigger in size means that the D50 is at least 52% bigger, at least 152% bigger, at least 252% bigger, at least 352% bigger, at least 452% bigger and even at least 752% bigger. In an embodiment, D50 refers to the particle size at which 50% of the sample's volume is comprised of smaller particles in the cumulative distribution of particle size. In an alternative embodiment, D50 refers to the particle size at which 50% of the sample's mass is comprised of smaller particles in the cumulative distribution of particle size. In an embodiment, the particle size is measured by laser diffraction according to ISO 13320-2009. In an embodiment, in a mixture of three or more powders at least one powder has a balanced composition regarding at least one critical element. In an embodiment, in a mixture of three or more powders at least one powder has a balanced composition regarding at least two critical elements. In an embodiment, in a mixture of three or more powders at least one powder has a balanced composition regarding at least three critical elements. In an embodiment, in a mixture of three or more powders at least one powder has a balanced composition regarding at least four critical elements. In an embodiment, in a mixture of three or more powders at least one powder has a balanced composition regarding at least five critical elements. In an embodiment, in a mixture of three or more powders at least one powder has a balanced composition regarding at least one of the sums of critical elements described above. In an embodiment, a balanced composition for a critical element or critical element sum is understood as having a composition (for the critical element or critical element sum) wherein: PACE*% PpCE=f1*% P1CE+f2*% kP2CE+ . . . +fx*% PxCE+ . . . fp*% PpCE, being PACE a parameter, fp the weight fraction within the mixture of the powder with the balanced composition, % PpCE the composition for the critical element or critical element sum of the balanced composition powder; f1, f2, . . . , fx, . . . the weight fractions of the other powders in the mixture and % P1CE. P2CE, . . . , PxCE, . . . the corresponding composition for the critical element or critical element sum. In an embodiment, a balanced composition for a critical element or critical element sum is understood as having a composition (for the critical element or critical element sum) wherein: PACE*% PpCE=f1*% P1CE+f2*% P2CE+ . . . +fx*% PxCE+ . . . being PACE a parameter, % PpCE the composition for the critical element or critical element sum of the balanced composition powder; f1, f2, . . . , fx, . . . the weight fractions of the other powders in the mixture and % P1CE, P2CE . . . , PxCE, . . . the corresponding composition for the critical element or critical element sum. In an embodiment, PACE has an upper limit and a lower limit. In different embodiments, the upper limit for PACE is 2.9, 1.9, 1.48, 1.19 and even 1.08. In different embodiments, the lower limit for PACE is 0.2, 0.55, 0.69, 0.79, 0.89 and even 0.96. In an embodiment, at least one of the powders with balanced composition for a critical element or critical element sum is considerably bigger in size (in the terms described above) than at least one of the critical element (or critical element sum) low content powders. In an embodiment, at least one of the powders with balanced composition for a critical element or critical element sum is considerably bigger in size (in the terms described above) than at least one of the critical element (or critical element sum) high content powders. In an embodiment, at least one of the powders with balanced composition for a critical element or critical element sum can be considered a critical element (or critical element sum) high content powder (in the terms described above) with respect of at least another powder of the mixture. In an embodiment, at least one of the powders with balanced composition for a critical element or critical element sum can be considered a critical element (or critical element sum) high content powder (in the terms described above) and considerably bigger in size (in the terms described above) with respect of at least another powder of the mixture. In an embodiment, at least one of the powders with balanced composition for a critical element or critical element sum can be considered a critical element (or critical element sum) low content powder (in the terms described above) with respect of at least another powder of the mixture. In an embodiment, at least one of the powders with balanced composition for a critical element or critical element sum can be considered a critical element (or critical element sum) low content powder (in the terms described above) and considerably bigger in size (in the terms described above) with respect of at least another powder of the mixture. In an embodiment, the powders in the mixture are chosen so that there is a considerable difference between the hardness of the softest powder and that of the hardest in the mixture. In different embodiments, a considerable difference is 6 HV or more, 12 HV or more, 26 HV or more, 52 HV or more, 78 HV or more 105 HV or more, 160 HV or more and even 205 HV or more. In some applications, the difference in hardness between powders is not as important as choosing at least one powder to have a considerable lower hardness than the final component. In an embodiment, there is a considerable difference between the hardness of least one powder of the mixture used to fill the mold and the final component. In an embodiment, at least one of the initial powders of the mixture is chosen so that there is a considerable difference (in the terms described above) between the hardness of this powder and the hardness of the final component after the complete application of the presently described method. In an embodiment, any superficial coating is removed from the end component prior to the measure of the hardness. In some applications, it has been found that it is important to choose at least one powder to have a low hardness. In an embodiment, at least one of the powders of the mixture is chosen with a low hardness. In an embodiment, at least one relevant powder of the mixture is chosen with a low hardness. In an embodiment, a moderately relevant amount of powder of the mixture is chosen with a low hardness. In different embodiments, in the present context, a low hardness is 289 HV or less, 189 HV or less, 148 HV or less, 119 HV or less, 89 HV or less and even 49 HV or less. In different embodiments, for a powder to be relevant it has to be present in at least 1.6 wt % or more, 2.6 wt % more, 5.6 wt % or more, 8.6 wt % or more, 12 wt % or more, 16 wt % or more and even 21 wt % or more (as in the rest of the document when not otherwise indicated percentage quantities are in weight percent). In different embodiments, for an amount of powder to be moderately relevant, the powder with the selected characteristic has to be relevant as has been described in the preceding lines but cannot be present in an amount exceeding 86 wt %, 59 wt %, 49 wt %, 29 wt %, 19 wt % and even 9 wt %. In different embodiments, in the present context, a low hardness is 288 HV or less, 248 HV or less, 188 HV or less, 148 HV or less, 128 HV or less and even 98 HV or less when the powder is mainly titanium. In different embodiments, in the present context, a low hardness is 288 HV or less, 248 HV or less, 188 HV or less, 148 HV or less, 128 HV or less and even 98 HV or less when the final component is mainly titanium. In different embodiments, for a powder or final material to be mainly a certain element, that element has to be present in 33 wt % or more, 52 wt % or more, 76 wt % or more, 86 wt % or more, 92 wt % or more, 96 wt % or more and even 99 wt % or more. In different embodiments, in the present context a low hardness is 288 HV or less, 248 HV or less, 188 HV or less, 148 HV or less, 98 HV or less and even 48 HV or less when the powder is mainly iron. In an embodiment, what has been said regarding low hardness of a powder when the powder is mainly iron, can be extended to a powder of the cited hardness not necessarily being mainly iron but the final component being mainly iron. In different embodiments, in the present context, a low hardness is 128 HV or less, 98 HV or less, 88 HV or less, 68 HV or less, 48 HV or less and even 28 HV or less when the powder is mainly aluminum. In an embodiment, what has been said regarding low hardness of a powder when the powder is mainly aluminum, can be extended to a powder of the cited hardness not necessarily being mainly aluminum but the final component being mainly aluminum. In an alternative embodiment, all what has been said about aluminum in the preceding lines can be extended to magnesium. In different embodiments, in the present context a low hardness is 288 HV or less, 248 HV or less, 188 HV or less, 148 HV or less, 118 HV or less, 98 HV or less and even 48 HV or less when the powder is mainly nickel. In an alternative embodiment, what has been said regarding low hardness of a powder when the powder is mainly nickel, can be extended to a powder of the cited hardness not necessarily being mainly nickel but the final component being mainly nickel. In different embodiments, in the present context, a low hardness is 348 HV or less, 288 HV or less, 248 HV or less, 188 HV or less, 148 HV or less, 98 HV or less and even 48 HV or less when the powder is mainly cobalt. In another embodiment, what has been said regarding low hardness of a powder when the powder is mainly cobalt, can be extended to a powder of the cited hardness not necessarily being mainly cobalt but the final component being mainly cobalt. In different embodiments, in the present context, a low hardness is 348 HV or less, 288 HV or less, 248 HV or less, 188 HV or less, 148 HV or less, 98 HV or less and even 48 HV or loss when the powder is mainly chromium. In another embodiment, what has boon said regarding low hardness of a powder when the powder is mainly chromium, can be extended to a powder of the cited hardness not necessarily being mainly chromium but the final component being mainly chromium. In different embodiments, in the present context, a low hardness is 288 HV or less, 248 HV or less, 188 HV or loss, 148 HV or less, 98 HV or less and even 48 HV or loss when the powder is mainly copper. In an alternative embodiment, what has been said regarding low hardness of a powder when the powder is mainly copper, can be extended to a powder of the cited hardness not necessarily being mainly copper but the final component being mainly copper. In an embodiment, the softer powder is not the largest powder. In an embodiment, for a powder to be the largest powder, it should be the powder with the highest D50. In an alternative embodiment, for a powder to be the largest powder, it should be the powder with the highest volume percentage. In another alternative embodiment, for a powder to be the largest powder, it should be the powder with the highest weight percentage. In an embodiment, there is a considerable difference between the hardness (as described above) of the relevant powder of the mixture chosen with a low hardness (as described above) and at least one powder type which is considerable bigger in size. In an embodiment, there is a considerable difference between the hardness (as described above) of the moderately relevant amount of powder of the mixture chosen with a low hardness (as described above) and at least one powder type which is considerably bigger in size. In an embodiment, the considerable bigger in size powder with a considerable higher hardness is present in a relevant amount (the same definition of relevant applies as above for the soft powder). In different embodiments, considerably bigger in size means that the D50 is at least 52% bigger, at least 152% bigger, at least 252% bigger, at least 352% bigger, at least 452% k bigger and even at least 752% bigger. In an embodiment, hardness is HV10 measured according to ISO 6507-1. In an alternative embodiment, hardness is HV10 measured according to ASTM E384-17. In another alternative embodiment, hardness is HV5 measured according to ISO 6507-1. In another alternative embodiment, hardness is HV5 measured according to ASTM E384-17. In an embodiment, there is a considerable difference between the sphericity of at least two of the powders in the mixture. In different embodiments, a considerable difference between the sphericity of at least two of the powders in the mixture is 5% or more, 12% or more, 22% or more and even 52% or more. In different embodiments, at least one of the powders in the mixture has a sphericity above 90%, above 92%, above 95% and even above 99%. In different embodiments, at least one of the powders in the mixture has a sphericity below 89%, below 83%, below 79% and even below 69%. In some applications, a certain difference between the sphericity of at least two of the powders in the mixture is preferred. In an embodiment, the powders are relevant powders in the mixture (as previously disclosed). In an embodiment, the powder mixture comprises at least a non-spherical powder. Unless otherwise stated, the feature “non-spherical powder” is defined throughout the present document in the form of different alternatives that are explained in detail below. In different embodiments, a non-spherical powder is a powder with a sphericity below 99%, below 89%, below 79%, below 74% and even below 69%. For some applications, the use of powders with very low sphericity is disadvantageous. In different embodiments, a non-spherical powder is a powder with a sphericity above 22%, above 36%, above 51% and even above 64%. In an embodiment, the powder mixture comprises at least a spherical powder. In an embodiment, the powder mixture comprises at least one powder obtained by gas atomization. In an embodiment, the powder mixture comprises at least one powder obtained by centrifugal atomization. In an embodiment, the powder or powder mixture comprises at least one powder rounded with a plasma treatment. Unless otherwise stated, the feature “spherical powder” is defined throughout the present document in the form of different alternatives that are explained in detail below. In an embodiment, a spherical powders means a powder obtained by gas atomization, centrifugal atomization and/or a powder rounded with a plasma treatment. In different embodiments, a spherical powder is a powder with a sphericity above 76%, above 82%, above 92%, above 96% and even 100%. In an embodiment, sphericity of the powder refers to a dimensionless parameter defined as the ratio between the surface area of a sphere having the same volume as the particle and the surface area of the particle. In an embodiment, sphericity (Ψ) is calculated using the formula: Ψ=[Π^{1/3}*(6*Vp)^{2/3}]/Ap. In this formula, w refers to the mathematical constant commonly defined as the ratio of a circle's circumference to its diameter, Vp is the volume of the particle and Ap is the surface area of the particle. In an embodiment, the sphericity of the particles is determined by dynamic image analysis. In an embodiment, the sphericity is measured by light scattering diffraction. For certain applications, a powder mixture comprising a high content of the larger powder (LP) is very advantageous. In different embodiments, the volume percentage of LP in the powder mixture is 85 vol % or more, 92 vol % or more, 96 vol % or more, 98.2 vol % or more, 99.4 vol % or more and even 100 vol % (the volume percentages are calculated taking into account only the metal comprising powders contained in the powder mixture). For some applications, the presence of other powders in the mixture is preferred. In different embodiments, the volume percentage of LP in the powder mixture is 7 vol % or more, 12 vol % or more, 21 vol % or more, 46 vol % or more, 51 vol % or more, 61 vol % or more, 71 vol % or more and even 81 vol % or more. In certain applications, the volume percentage should be limited. In different embodiments, the volume percentage of LP in the powder mixture is 89 vol % or less, 79 vol % or less, 69 vol % or less, 49 vol % or less and even 19 vol % or less (the volume percentages are calculated taking into account only the metal comprising powders contained in the powder mixture). For certain applications, a LP with a high sphericity is advantageous. In an embodiments, when LP is a spherical powder (as previously defined), the volume percentage of LP in the powder mixture is the right volume percentage of spherical LP. In different embodiments, the right volume percentage of spherical LP is 52 vol % or more, 61 vol % or more, 66 vol % or more and even 71 vol % or more (volume percentages are calculated taking into account only the metal comprising powders in the mixture. In certain applications, the volume percentage should be limited. In different embodiments, the right volume percentage of spherical LP is 84 vol % or less, 79 vol % or less and even 69 vol % or less (the volume percentages are calculated taking into account only the metal comprising powders contained in the powder mixture). For certain applications, a LP with a low sphericity is advantageous. In an embodiment, when LP is a non-spherical powder (as previously defined), the volume percentage of LP in the powder mixture is the right volume percentage of non-spherical LP. In different embodiments, the right volume percentage of non-spherical LP is 41 vol % or more, 51 vol % or more, 56 vol % or more and even 61 vol % or more (the volume percentages are calculated taking into account only the metal comprising powders contained in the powder mixture). In certain applications, the volume percentage should be limited. In different embodiments, the right volume percentage of non-spherical LP is 79 vol % or less, 70 vol % or less, 64 vol % or less and even 59 vol % or less (the volume percentages are calculated taking into account only the metal comprising powders contained in the powder mixture). In an embodiment, ceramics are included among the metal comprising powders. As already indicated, the powder mixtures described in this paragraph and the neighboring ones are very interesting for applications of MAM where shape is provided with the help of an organic material. In an embodiment, the powder mixture is shaped with the aid of an organic material. In another embodiment, the powder mixture is shaped with the aid of a polymeric material. In another embodiment, the powder mixture is shaped with the aid of a binder material. In another embodiment, the powder mixture is shaped with the aid of an organic material as a shaping mold. In another embodiment, the powder mixture is shaped with the aid of a polymeric material as a shaping mold. In an embodiment, the powder mixture comprises also an organic material (not necessarily in powder shape). In another embodiment, the powder mixture comprises also a polymeric material (not necessarily in powder shape). In another embodiment, the powder mixture comprises also a binder material sticking some of the metallic particles together. In an embodiment, the powder mixture comprises at least two powders with different size. When it comes to the quantification of “larger”, different applications benefit from different definitions. In different embodiments, larger means that the powder size critical measure is 1.5 times as big or more, 2 times as big or more, 4 times as big or more, 8 times as big or more and even 10.5 times as big or more. For some applications, excessive difference between the powder sizes has proven to be disadvantageous. In different embodiments, larger means that the powder size critical measure is at most 900 times larger, 400 times larger, 90 times larger, 45 times larger and even 19 times larger. Unless otherwise stated, the feature “powder size critical measure” is defined throughout the present document in the form of different alternatives that are explained in detail below. In an embodiment, the powder size critical measure is D50. In an alternative embodiment, the powder size critical measure is D10. In another alternative embodiment, the powder size critical measure is D90. In an embodiment, D50 refers to a particle size at which 50% of the sample's volume is comprised of smaller particles in the cumulative distribution of particle size. In an alternative embodiment, D50 refers to a particle size at which 50% of the sample's mass is comprised of smaller particles in the cumulative distribution of particle size. In an embodiment, D10 refers to a particle size at which 10% of the sample's volume is comprised of smaller particles in the cumulative distribution of particle size. In an alternative embodiment. D10 refers to a particle size at which 10% of the sample's mass is comprised of smaller particles in the cumulative distribution of particle size In an embodiment, D90 refers to a particle size at which 90% of the sample's volume is comprised of smaller particles in the cumulative distribution of particle size. In an embodiment, D90 refers to a particle size at which 90% of the sample's mass is comprised of smaller particles in the cumulative distribution of particle size In another alternative embodiment, the powder size critical measure is the average size. In an embodiment, particle size is measured by laser diffraction according to ISO 13320-2009. In another alternative embodiment, the powder size critical measure is the smallest mesh that lets only 10% of the powder retained. In another alternative embodiment, the powder size critical measure is the smallest mesh that allows 50% of the powder pass through. All the embodiments disclosed above can be combined among them and with any other embodiment disclosed in this document that relates to “powder size critical measure” in any combination, provided that they are not mutually exclusive. For some applications, the size of the smaller powder matters, not only the difference to the larger powder. In different embodiments, the smaller powder presents a size critical measure of 88 microns or less, of 38 microns or less, of 28 microns or less, of 18 microns or less, of 8 microns or less and even of 0.8 microns or less. For some applications, while there might be even smaller powders present in the mixture, the so called smaller powder should not have too small of a size. In different embodiments, the smaller powder presents a size critical measure of 0.8 nanometers or more, of 80 nanometers or more, of 600 nanometers or more and even of 1050 nanometers or more. In an embodiment, the powder mixture comprises at least two powders with different morphology, being one of the powders more irregular than the other. In different embodiments, more irregular means that the sphericity is 11% lower or loss, 21% lower or less, 41% lower or less, 52% lower or less 61% lower or loss and even 81% lower or less. In different embodiments, more irregular means that the sphericity value is lower than the result of dividing the sphericity value of the less irregular powder by 1.1, by 1.6 and even by 2.1. In an embodiment, sphericity of the powder refers to a dimensionless parameter defined as the ratio between the surface area of a sphere having the same volume as the particle and the surface area of the particle. In an embodiment, sphericity (Ψ) is calculated using the formula: Ψ=[(Π^{1/3}*(6*Vp)^{2/3}]/Ap. In this formula, Π refers to the mathematical constant commonly defined as the ratio of a circle's circumference to its diameter, Vp is the volume of the particle and Ap is the surface area of the particle. In an embodiment, the sphericity of the particles is determined by dynamic image analysis. In an alternative embodiment, the sphericity is measured by light scattering diffraction. For some applications, it is advantageous to measure irregularity in terms of active surface/weight. In different embodiments, the result of dividing the mean active surface per unit weight of the more irregular powder by the mean active surface per unit weight of the less irregular powder yields at least 1.1, at least 1.23, at least 1.6 and even at least 2.1. In different embodiments, the right proportion means the smaller powder volume fraction divided by the volume fraction of the larger powder yields 4.9 or less, 1.9 or less, 1.4 or less and even 0.98 or less. In different embodiments, the right proportion means the smaller powder volume fraction divided by the volume fraction of the larger powder yields 0.05 or more, 0.12 or more, 0.26 or more, 0.44 or more and even 0.61 or more. A few applications also work without the irregularity difference that means powders with similar irregularity can be employed. In an embodiment, a powder mixture capable of high interlocking and high performance comprising at least two powders in the right proportion to each other, both in the same base but one larger than the other is claimed. For several applications it is advantageous for at least two of the powders to have different natures in terms of chemical composition. In an embodiment, the two powders which are different morphologically have also a different chemical composition. In an embodiment, one of the powders has a relevant difference in at least one element. In an embodiment, one of the powders has a relevant difference in at least two elements. In an embodiment, one of the powders has a relevant difference in at least three elements. In an embodiment, one of the powders has a relevant difference in at least four elements. In an embodiment, one of the powders has a relevant difference in at least five elements. In an embodiment, a relevant difference means at least 20 wt % or more. In another embodiment, a relevant difference means at least 60 wt % or more. In another embodiment, a relevant difference means at least twice as much. In an embodiment, a relevant difference means at least four times more. In an embodiment, a relevant difference means twenty times or less. In another embodiment, a relevant difference means ten times or less. In another embodiment, a relevant difference means 99 wt % or less. In another embodiment, a relevant difference means 90 wt % or less. In another embodiment, a relevant difference means 80 wt % or less. In an embodiment, only relevantly present elements are taken into account. In different embodiments, relevantly present elements are those present in a quantity of 0.012 wt % or more, 0.12 wt % or more, 0.32 wt % or more, 0.62 wt % or more, 1.2 wt % or more and even 5.2 wt % or more. In an embodiment, the smaller powder has a lower level of alloying in at least one element and it is a relevant difference. In another embodiment, the smaller powder has a lower level of alloying in at least two elements and it is a relevant difference. In another embodiment, the smaller powder has a lower level of alloying in at least three elements and it is a relevant difference. In another embodiment, the smaller powder has a lower level of alloying in at least five elements and it is a relevant difference. In an embodiment, the term element/elements refer to any element of the periodic table. In an alternative embodiment, the term element/elements refer to any element of the periodic table with atomic number between 5 and 95. In another alternative embodiment, the term element/elements refer to any element of the periodic table with atomic number between 12 and 88. In another alternative embodiment, the term element/elements refer to any element of the periodic table with atomic number between 22 and 43. For some applications, it is particularly interesting when some peculiarities are observed for the smaller powder. In an embodiment, the smaller powder is manufactured through the carbonyl process. In an embodiment, the smaller powder has a particular low level of interstitials. In an embodiment, the smaller powder has a particular low level of oxygen. In an embodiment, the smaller powder has a particular low level of nitrogen. In an embodiment, the smaller powder has a particular low level of carbon. In different embodiments, a particular low level means 1900 ppm or less, 900 ppm or less, 400 ppm or less, 190 ppm or less, 90 ppm or less and even 19 ppm or less. For some applications, an excessively low level is not advantageous. In different embodiments, a particular low level should not be less than 0.1 ppm, less than 1.1 ppm, less than 11 ppm, less than 21 ppm and even less than 100 ppm. In an embodiment, the levels of at least some of the interstitials are brought to the desired level by interaction of the powder with a particular atmosphere. In an embodiment, the levels of at least some of the interstitials are brought to the desired level by reduction of the powder. In an embodiment, the levels of at least some of the interstitials are brought to the desired level by the employment of the method to treat powders with the help of microwaves described in this document. For some applications, it is also interesting to control the level of at least some of the interstitials in the larger powder. In an embodiment, what has been said above regarding particular types of interstitials for the smaller powder applies also to the larger powder. For some applications, particularly in some very demanding applications, it is not sufficient to control just two powders of the powder mixture and at least a third powder has to be strictly monitored. In an embodiment, the third powder has a relevant difference in at least one element compared to the reference powder. In another embodiment, one of the powders has a relevant difference in at least two elements compared to the reference powder. In another embodiment, one of the powders has a relevant difference in at least three elements compared to the reference powder. In another embodiment, one of the powders has a relevant difference in at least four elements compared to the reference powder. In another embodiment, one of the powders has a relevant difference in at least five elements compared to the reference powder. In an embodiment, the reference powder is the smaller powder. In an embodiment, the reference powder is the larger powder. In an embodiment, the reference powder is both the smaller and the larger powder. In an embodiment, the larger powder is “larger” (in the terms described above) than the third powder. In an embodiment, the smaller powder is “larger” (in the terms described above) than the third powder. In an embodiment, at least a fourth powder type has to be strictly controlled, and what has been said about the third powder also applies to the fourth powder, although the fourth and the third powder can be different to each other in one or several of the properties characterized but within the ranges specified for both. In an embodiment, at least a fifth powder type has to be strictly controlled, and what has been said about the third powder also applies to the fifth powder, although the fifth and the third powder can be different to each other in one or several of the properties characterized but within the ranges specified for both. In an embodiment, at least a sixth powder type has to be strictly controlled, and what has been said about the third powder also applies to the sixth powder, although the sixth and the third powder can be different to each other in one or several of the properties characterized but within the ranges specified for both. For some applications, it is interesting to have at least one of the powders with alloying added. In an embodiment, one of the powders has diffusion bonded alloying. In an embodiment, the larger powder has diffusion bonded alloying. In an embodiment, one of the powders is homogenously alloyed. In an embodiment, the larger powder is homogenously alloyed. In an embodiment, homogeneously alloyed means that not two critical volumes can be found with relevant difference (in the terms described above) in the content of at least one alloying element (there might be some elements where such relevant difference occur, but there is at least one element where they do not occur). In an embodiment, homogeneously alloyed means that not two critical volumes can be found with relevant difference in the content of at least two alloying elements. In another embodiment, homogeneously alloyed means that not two critical volumes can be found with relevant difference in the content of at least three alloying elements. In another embodiment, homogeneously alloyed means that not two critical volumes can be found with relevant difference in the content of at least four alloying elements. In another embodiment, homogeneously alloyed means that not two critical volumes can be found with relevant difference in the content of at least five alloying elements. In an embodiment, a critical volume is 50% of the total volume of the powder particle. In another embodiment, a critical volume is 30% of the total volume of the powder particle. In another embodiment, a critical volume is 25% of the total volume of the powder particle. In another embodiment, a critical volume is 10% of the total volume of the powder particle. In an embodiment, a critical volume is 50% of the total volume of the powder. In another embodiment, a critical volume is 25% of the total volume of the powder. In another embodiment, a critical volume is 10% of the total volume of the powder. For some applications, it is interesting to have some of the relevant alloying of the larger powder coincide with the average alloying of some of the smaller powders at least for some relevantly present elements. In an embodiment, the larger powder presents a similar alloying level for at least one relevantly present element when compared to the average of at least two smaller powders. In another embodiment, the same applies for at least three relevantly present elements. In another embodiment, the same applies for at least four relevantly present elements. In another embodiment, the same applies for at least five relevantly present elements. In another embodiment, the same applies for at least six relevantly present elements. In another embodiment, the same applies for the average of at least three smaller powders. In another embodiment, the same applies for the average of at least the smaller powder and the third powder. In another embodiment, the same applies for the average of at least the smaller powder and the third and fourth powders. In another embodiment, the same applies for the average of at least the smaller powder and the third, fourth and fifth powders. In another embodiment, the same applies for the average of at least the smaller powder and at least another powder which is not the larger powder. In another embodiment, the same applies for the average of at least the smaller powder and at least two more powders which are not the larger powder. In another embodiment, the same applies for the average of at least the smaller powder and at least three more powders which are not the larger powder. In another embodiment, the same applies for the average of at least the smaller powder and at least four more powders which are not the larger powder. In another embodiment, the same applies for the average of at least the smaller powder and at least five more powders which are not the larger powder. In another embodiment, the same applies for the average of at least the smaller powder and at least six more powders which are not the larger powder. In an embodiment, a similar alloying level means that the alloying level of the average for the element of interest is between 1.9×LEV and 0.2×LEV where LEV is the alloying level of the larger powder for that element. In another embodiment, the same applies but between 1.74×LEV and 0.6×LEV. In another embodiment, the same applies but between 1.44×LEV and 0.7×LEV. In another embodiment, the same applies but between 1.19×LEV and 0.81×LEV. In another embodiment, the same applies but between 1.09×LEV and 0.91×LEV. For some applications, it is interesting for the larger powder to have a similar alloying level for some relevantly present elements to the overall alloying (alloying level after sintering or sintering and HIP of the powder mixture). In an embodiment, the larger powder has a similar alloying level for at least one relevantly present element to the overall alloying. In an embodiment, the larger powder has a similar alloying level for at least two relevantly present elements to the overall alloying. In an embodiment, the larger powder has a similar alloying level for at least three relevantly present elements to the overall alloying. In an embodiment, the larger powder has a similar alloying level for at least four relevantly present elements to the overall alloying. In an embodiment, the larger powder has a similar alloying level for at least five relevantly present elements to the overall alloying. For some applications, especially some of the applications where the method of the present invention is applied, it has been found advantageous to have the larger powder alloyed with several of the relevantly present elements but not the interstitials. In an embodiment, the larger powder has a similar alloying level for at some of the relevantly present element to the overall alloying but presents a low % C. In an embodiment, the larger powder has a similar alloying level for at some of the relevantly present element to the overall alloying but presents a low % N. In an embodiment, the larger powder has a similar alloying level for at some of the relevantly present element to the overall alloying but presents a low % B. For some applications it has been surprisingly found that for the case of % B it is interesting to have the larger powder with a similar alloying level to the overall alloying or even slightly higher. In an embodiment, the larger powder has a similar alloying level for % B to the overall alloying. In an embodiment, the larger powder presents an alloying level for % B which is larger than 1.06*% B of the overall alloying. In an embodiment, the larger powder presents an alloying level for % B which is larger than 1.12*% B of the overall alloying. In an embodiment, the larger powder presents an alloying level for % B which is larger than 1.26*% B of the overall alloying. In an embodiment, at least part of the missing % C of the larger powder compared to the overall alloying is introduced as graphite. In an embodiment, at least part of the missing % C of the larger powder compared to the overall alloying is introduced with the smaller powder. In an embodiment, at least part of the missing % C of the larger powder compared to the overall alloying is introduced with one of the other powders. In an embodiment, at least part of the missing % C of the larger powder compared to the overall alloying is introduced as a third powder. In an embodiment, at least part of the missing % N of the larger powder compared to the overall alloying is introduced as a nitride. In an embodiment, at least part of the missing % N of the larger powder compared to the overall alloying is introduced as a gas in the processing atmosphere. In an embodiment, one of the alloying elements is % Mo. In an embodiment, one of the alloying elements is % Mn. In an embodiment, one of the alloying elements is % Ni. In an embodiment, one of the alloying elements is % V. In an embodiment, one of the alloying elements is % Al. In an embodiment, one of the alloying elements is % Ti. In an embodiment, one of the alloying elements is % Cr. In an embodiment, one of the alloying elements is % Nb. In an embodiment, one of the alloying elements is % Si. In an embodiment, one of the alloying elements is % W. In an embodiment, one of the alloying elements is % Ta. In an embodiment, one of the alloying elements is % Fe. In an embodiment, one of the alloying elements is % Co. In an embodiment, one of the alloying elements is % Zr. In an embodiment, one of the alloying elements is % Be. In an embodiment, one of the alloying elements is % Sn. In an embodiment, one of the alloying elements is % Zn. In an embodiment, one of the alloying elements is % B. For some applications, to achieve the desirable interlocking effect it is important to correctly choose the filling or packing density. In an embodiment, the filling density is the relative density of all the powders. In an alternative embodiment, the filling density is the relative density of the metallic powders. In another alternative embodiment, the filling density is measured right before the powders are compacted. In another alternative embodiment, the filling density is measured right before the powders are subjected to pressure. In another alternative embodiment, the filling density is measured once the powders have been bonded by a binder. In another alternative embodiment, the filling density is measured in the brown component right after the binder has been eliminated. In different embodiments, the correct filling density is 42% or more, 52% or more, 62% or more, 66% or more, 70.5% or more, 72% or more, 74% or more and even 76% or more. In several applications, excessive filling density brings about inhomogeneities in the interlocking effect. In different embodiments, the correct filling density is 89% or less, 84% or less, 79% or less and even 74.5% or less. In an embodiment, the process to achieve the correct filling density involves vibration. In an embodiment, the process to achieve the correct filling density involves tapping. In an embodiment, at least one of the powders of the mixture comprises % Y. % Sc, and/or % REE. In an embodiment, when the reference is made to compositions, the use of terms such as “below”, “above”, “or more”, “or less”, “from,” “to,” “up to,” “at least,” “greater than,” “more than”, “less than,” “more than” and the like, refers to compositional ranges that can subsequently be broken down into sub-ranges and combined with other upper and/or lower limits in any combination provided that they are not mutually exclusive. In an embodiment, at least one of the powders of the mixture comprises % Y. In an embodiment, the powder mixture comprises % Y. In different embodiments, % Y is above 0.012 wt %, above 0.052 wt %, above 0.12 wt %, above 0.22 wt %, above 0.42 wt % and even above 0.82 wt %. For some applications, excessive % Y may adversely affect the mechanical properties. In different embodiments, % Y is below 1.4 wt %, below 0.96 wt %, below 0.74 wt % and even below 0.48 wt %. In an embodiment, at least one of the powders of the mixture comprises % Sc. In an embodiment, the powder mixture comprises % Sc. In different embodiments, % Sc is above 0.012 wt %, above 0.052 wt %, above 0.12 wt %, above 0.22 wt %, above 0.42 wt % and even above 0.82 wt %. For some applications, excessive % Sc may adversely affect the mechanical properties. In different embodiments, % Sc is below 1.4 wt %, below 0.96 wt %, below 0.74 wt % and even below 0.48 wt %. In an embodiment, the powder mixture comprises % Sc+% Y. In different embodiments, % Y+% Sc is above 0.012 wt %, above 0.052 wt %, above 0.12 wt %, above 0.22 wt %, above 0.42 wt % and even above 0.82 wt %. For some applications, excessive % Y+% Sc seems to deteriorate the mechanical properties. In different embodiments, % Y+% Sc is below 1.4 wt %, below 0.96 wt %, below 0.74 wt % and even below 0.48 wt %. In an embodiment, at least one of the powders of the mixture comprises % REE. In an embodiment, the powder mixture comprises % REE. In different embodiments, % REE is above 0.012 wt %, above 0.052 wt %, above 0.12 wt %, above 0.22 wt %, above 0.42 wt % and even above 0.82 wt %. For some applications, excessive % REE may adversely affect the mechanical properties. In different embodiments, % REE is below 1.4 wt %, below 0.96 wt %, below 0.74 wt % and even below 0.48 wt %. In an embodiment, the powder mixture comprises % Sc+% Y+% REE. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments, % Sc+% Y+% REE is below 1.4 wt %, below 0.96 wt %, below 0.74 wt % and even below 0.48 wt %. Unless otherwise stated, the “% REE” is defined throughout the present document in the form of different alternatives, that are explained in detail below. In an embodiment, % REE is any actinide element. In an alternative embodiment, % REE is any lanthanide element. In another alternative embodiment, % REE is the sum of % La+% Ce+% Pr+% Nd+% Pm+% Sm+% Eu+% Gd+% Th+% Dy+% Ho+% Er+% Tm+% Yb+% Lu. In another alternative embodiment, % REE is the sum of % Ac+% Th 50+% Pa+% U+% Np+% Pu+% Am+% Cm+% Bk+% Cf+% Es+% Fm+% Md+% No+% Lr. In another alternative embodiment, % REE is the sum of lanthanides and actinides. In another alternative embodiment, % REE is % La. In another alternative embodiment, % REE is % Ac. In another alternative embodiment, % REE is % Ce. In another alternative embodiment, % REE is % Nd. In another alternative embodiment, % REE is % Gd. In another alternative embodiment, % REE is % Sm. In another alternative embodiment, % REE is % Pr. In another alternative embodiment, % REE is % Pm. In another alternative embodiment, % REE is % Eu. In another alternative embodiment, % REE is % Th. In another alternative embodiment, % REE is % Dy. In another alternative embodiment, % REE is % Ho. In another alternative embodiment, % REE is % Er. In another alternative embodiment, % REE is % Tm. In another alternative embodiment, % REE is % Yb. In another alternative embodiment. % REE is % Lu. In another alternative embodiment, % REE is replaced partially or totally by % Cs. All the embodiments disclosed above can be combined with any other embodiment disclosed in this document that relates to “% REE” in any combination, provided that they are not mutually exclusive. In an embodiment, the powder mixture comprises % O. In different embodiments, the % O of the mixture is above 8 ppm, above 22 ppm, above 110 ppm, above 210 ppm, above 510 ppm and even above 1010 ppm. For some applications, excessive % O may adversely affect the mechanical properties. In different embodiments, the % O content of the mixture is below 2900 ppm, below 1900 ppm, below 900 ppm and even below 490 ppm. For some applications, it has been found that the relation between % O and % Y+% Sc or alternatively % Y or alternatively % Y+% Sc+% REE has to be controlled for optimum mechanical properties of the final component (in this case percentages are atomic percentages). In an embodiment, KYO1*atm % O<atm % Y<KYO2*atm % O has to be met wherein atm % O means atomic percentage of oxygen and atm % Y means atomic percentage of yttrium. In another embodiment, KYO1*atm % O<atm % Y+atm % Sc<KYO2*atm % O. In another embodiment, KYO1*atm % O<atm % Y+atm % Sc+atm % REE<KYO2*atm % O, being % REE as previously defined. In different embodiments, KYO1 is 0.01, 0.1, 0.2, 0.4, 0.6 and even 0.7. In different embodiments, KYO2 is 0.5, 0.66, 0.75, 0.85, 1 and even 5. For some applications, particularly when the base is not Ti, then % Y can be partially replaced with % Ti. In an embodiment, at least 12 wt % of % Y is replaced with % Ti. In another embodiment, at least 22 wt % of % Y is replaced with % Ti. In another embodiment, at least 42 wt % of % Y is replaced with % Ti. In another embodiment, at least 62 wt % of % Y is replaced with % Ti. In another embodiment, at least 82 wt % of % Y is replaced with % Ti. In a few applications, % Y can be totally replaced with % Ti. In an embodiment, % Y is replaced with % Ti. But most applications suffer from such total replacement. In an embodiment, no more than 92 wt % of % Y is replaced with % Ti. In another embodiment, no more than 82% of % Y is replaced with % Ti. In another embodiment, no more than 62 wt % of % Y is replaced with % Ti. In another embodiment, no more than 42 wt % of % Y is replaced with % Ti. For some applications, especially when the base is Fe, Ti, Ni, Cu or Al, it is quite interesting when the larger powder is the one comprising % Y, % Sc, % REE and/or % Ti. In an embodiment, at least the larger powder comprises % Y, % Sc, % REE and/or % Ti in the terms described in this paragraph. In another embodiment, only the larger powder comprises % Y, % Sc, % REE and/or % Ti in the terms described in this paragraph. In another embodiment, at least the larger powder comprises % Y, % Sc, % REE and/or % Ti in pre-alloyed form and in the terms described in this paragraph. In another embodiment, at least the larger powder comprises % Y, % Sc, % REE and/or % Ti in pre-alloyed form and in the terms described in this paragraph and the weighted sum of all other powders (average composition of all other powders together) has a similar alloying level (in the sense described in this paragraph) of these elements. In another embodiment, at least the larger powder comprises % Y, % Sc, % REE and/or % Ti in pro-alloyed form and in the terms described in this paragraph and the weighted sum of at least some of the other powders (average composition of some of the other powders present in the mixture) has a similar alloying level of these elements. There are thousand examples and further limitations for the powder mixture described in this paragraph with interest for different applications, an extensive list does not seem rational, so the inventor has chosen a few to serve as illustration proposes, which are presented in the following paragraphs (each paragraph with one such example should be considered a continuation of the present paragraph in terms of content and combination ability, but have been separated only to favor readability). Also, in those paragraphs the following nomenclature has been chosen: LP—larger powder; SP—smaller powder; AP1, AP2, AP3, AP4 . . . —Other relevant powders (as previously defined), APx—generic term for a relevant powder other than SP and LP. In an embodiment, LP and SP are the same powder. In an embodiment LP and SP have the same composition.

For several applications, including most plastic injection molds, it is interesting to have a steel with as high a thermal conductivity as possible and good mechanical properties especially in terms of toughness and sufficient yield strength, and where tribological performance is often less of a concern. While the formulations provided for the powder mix might constitute an invention on their own. In some instances, also the final overall composition might also constitute a standalone invention. For such applications, the inventor has found that the following powder mixture (comprising at least LP and SP) is of interest:

LP is a powder having the following composition, all percentages being indicated in weight percent: % Mo: 0-3.9;% W: 0-3.9; % Moeq: 0.6-3.9; % Ceq: 0-0.49; % C: 0-0.49; % N: 0-0.2; % B: 0-0.8; % Si: 0-2.5; % Mn: 0-2.9; % Ni: 0-2.9; % Mn+2*% Ni: 0-3.8; % Cr: 0-2.9; % V: 0-2.9; % Nb: 0-2.9; % Zr: 0-3.9; % Hf: 0-2.9; % Ta: 0-2.9; % S: 0-0.8; % P: 0-0.8; % Pb: 0-1.9; % Cu: 0-3.9; % Bi: 0-0.8; % Se: 0-0.8; % Co: 0-3.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq=% Mo+*% W: and wherein % REE is as previously defined. In an embodiment, trace elements refers to several elements, including but not limited to H, He, Xe, F, No, Na, CI, Ar, K, Br, Kr, Sr, Tc, Ru, Rh, Ti, Pd, Ag, I, Ba, Re, Os, Ir, Pt, Au, Hg, Tl, Po, At, Rn, Fr, Ra, Rf, Db, Sg, Bh, Hs, Li, Be, Mg, Ca, Rb, Zn, Cd, Al, Ga, In, Ge, Sn, Sb, As, Te, Ds, Rg, Cn, Nh, Fl, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the presence of % Y is desirable, while in other applications, it is rather an impurity. In different embodiments, % Y is above 0.012 wt %, above 0,052 wt %, above 0.12 wt %, above 0.22 wt %, above 0.42 wt % and even above 0.82 wt %. For some applications, an excessive content of % Y may adversely affect the mechanical properties. In different embodiments, % Y is below 0.74 wt %, below 0.48 wt %, below 0.34 wt %, below 0.18 wt % and even below 0.09 wt %. Obviously, there are cases where the desired nominal content is Owt % or nominal absence of the element as occurs with all optional elements for certain applications. For some applications, the presence of % Sc is desirable, while in other applications, it is rather an impurity. In different embodiments, % Sc is above 0.012 wt %, above 0.052 wt %, above 0.12 wt %, above 0.22 wt %, above 0.42 wt % and even above 0.82 wt %. For some applications, an excessive content of % Sc may adversely affect the mechanical properties. In different embodiments, % Sc is below 0.74 wt %, below 0.48 wt %, below 0.34 wt % and even below 0.18 wt %. Obviously, there are cases where the desired nominal content is Owt % or nominal absence of the element as occurs with all optional elements for certain applications. For some applications, a certain content of % Sc+% Y is desirable. In different embodiments. % Sc+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt %. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, an excessive content of % REE may adversely affect the mechanical properties. In different embodiments, % REE is below 1.4 wt %, below 0.96 wt %, below 0.74 wt % and even below 0.48 wt %. Obviously, there are cases where the desired nominal content is Owt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments, % Sc+% Y+% REE is below 1.4 wt %, below 0.96, below 0.74 wt % and even below 0.48 wt %. In some embodiments, the above disclosed for the content of % O, % Cs, % Y, % Sc, % REE and/or % Ti can also be applied to the composition of LP. For some applications, the relation between the atomic content of % O and % Y+% Sc or alternatively % Y or alternatively % Y+% Sc+% REE has to be controlled for optimum mechanical properties according to the formulas previously disclosed. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, an excessive content of % O may adversely affect the mechanical properties. In different embodiments, % O is below 2990 ppm, below 1900 ppm, below 900 ppm and even below 490 ppm. Obviously, there are cases where the desired nominal content is 0 wt % or nominal absence of the element as occurs with all optional elements for certain applications. For some applications, the presence of % C is desirable, while in other applications, it is rather an impurity. In different embodiments, % C is above 0.01 wt %, above 0.09 wt %, above 0.11 wt %, above 0.16 wt %, above 0.21 wt % and even above 0.26 wt %. For some applications, higher % C contents are preferred. In different embodiments, % C is above 0.28 wt % and even above 0.31 wt %, above 0.34 wt %, above 0.36 wt % and even above 0.416 wt %. For some applications, an excessive content of % C may adversely affect the mechanical properties. In different embodiments, % C is below 0.44 wt %, below 0.39 wt %, below 0.29 wt % and even below 0.24 wt %. Some applications benefit from a low interstitial content level in the generalized way already exposed, but some applications present even better results with somewhat different control over the level of interstitials. In different embodiments, % C is kept below 2890 ppm, below 890 ppm, below 490 ppm, below 196 ppm and even below 96 ppm. Obviously, there are cases where the desired nominal content is 0 wt % or nominal absence of the element as occurs with all optional elements for certain applications. For some applications, the presence of % Ceq is desirable, while in other applications, it is rather an impurity. In different embodiments, % Ceq is above 0.06 wt %, above 0.16 wt %, above 0.19 wt %, above 0.23 wt % and even above 0.26 wt %. For some applications, higher % Ceq contents are desirable for either high wear resistance or where a fine bainite is desirable. In different embodiments. % Ceq is above 0.28 wt %, above 0.32 wt %, above 0.37 wt % and even above 0.42 wt %. On the other hand, for some applications, too high levels of % Ceq lead to impossibility to attain the required nature and perfection of carbides (nitrides, borides, oxides or combinations) regardless of the heat treatment applied. In different embodiments, % Ceq is less than 0.44 wt %, less than 0.34 wt %, below 0.24 wt %, below 0.17 wt %, below 0.14 wt % and even below 0.1 wt %. As previously disclosed, some applications benefit from a low interstitial content level. In different embodiments, % Ceq is kept below 890 ppm, below 490 ppm, below 90 ppm and even below 40 ppm. Obviously, there are cases where the desired nominal content is Owt % or nominal absence as occurs with all optional elements for certain applications. For some applications, the presence of % N is desirable, while in other applications it is rather an impurity. In different embodiments, % N is above 0.0001 wt %, above 0.001 wt %, above 0.009 wt %, above 0.09 wt % and even above 0.01 wt %. For some applications, higher % N contents are preferred. In different embodiments, % N is above 0.06 wt %, above 0.09 wt %, above 0.1 wt % and even above 0.13 wt %. As previously disclosed, some applications benefit from a low interstitial content level. In different embodiments. % N is kept below 1900 ppm, below 900 ppm, below 490 ppm, below 190 ppm, 90 ppm and even below 40 ppm. Obviously, there are cases where the desired nominal content is Owt % or nominal absence of the element as occurs with all optional elements for certain applications. For some applications, the presence of % Mo is desirable, while in other applications it is rather an impurity. In different embodiments, % Mo is above 0.3 wt %, above 0.6 wt %, above 1.1 wt % and even above 1.4 wt %. For some applications, higher % Mo contents are preferred for high thermal conductivity. In different embodiments. % Mo is above 1.6 wt %, above 1.8 wt %, above 2.1 wt % and even above 3.1 wt %. For some applications, an excessive content of % Mo may adversely affect the mechanical properties. In different embodiments. % Mo is below 2.9 wt %, below 2.4 wt %, below 1.7 wt %, below 1.3 wt %, below 0.94 wt % and even below 0.49 wt %. Obviously, there are cases where the desired nominal content is Owt % or nominal absence of the element as occurs with all optional elements for certain applications. In some embodiments. % Mo can be partially replaced with % W. This replacement takes place in terms of % Moeq. In different embodiments, the replacement of % Mo with % W is lower than 74 wt %, lower than 59 wt %, lower than 39 wt % and even lower than 14 wt %. For applications where thermal conductivity is to be maximized but thermal fatigue has to be regulated, it is normally preferred to have from 1.2 to 3 times more % Mo than % W, but not absence of % W. For some applications, higher % Moeq contents are preferred for high thermal conductivity. In different embodiments, % Moeq is above 1.3 wt %, above 1.6 wt %, above 1.8 wt %, above 2.1 wt % and even above 2.6 wt %. On the other hand, for some applications, an excessive content of % Moeq may adversely affect the mechanical properties. In different embodiments, % Moeq is below 3.4 wt %, below 2.9 wt %, below 2.6 wt %, below 2.4 wt %, below 2.2 wt % and even below 1.9 wt %. For some applications, lower % Moeq contents are preferred. In different embodiments, % Moeq is below 1.6 wt %, below 1.4 wt %, below 1.1 wt %, below 0.9 wt % and even below 0.74 wt %. For some applications, the presence of % W is desirable, while in other applications it is rather an impurity. In different embodiments, % W is above 0.26 wt %, above 0.86 wt %, above 1.16 wt % and even above 1.66 wt %. For some applications, an excessive content of % W may adversely affect the mechanical properties. In different embodiments, % W is below 2.4 wt %, below 1.4 wt % and even below 0.9 wt %. For some applications, lower % W contents are preferred. In different embodiments, % W is below 0.8 wt %, below 0.74 wt % and even below 0.39 wt %. Obviously, there are cases where the desired nominal content is Owt % or nominal absence of the element as occurs with all optional elements for certain applications. For some applications, the presence of % V is desirable, while in other applications it is rather an impurity. In different embodiments, % V is above 0.06 wt %, above 0.17 wt %, above 0.21 wt % above 0.26 wt %, above 0.56 wt % and even above 0.76 wt %. For some applications, an excessive content of % V may adversely affect the mechanical properties. In different embodiments, % V is below 2.3 wt %, below 1.8 wt %, below 1.3 wt % and even below 0.98 wt %. The inventor has found that for some applications, lower % V contents are preferred. In different embodiments, % V is below 0.89 wt %, below 0.49 wt %, below 0.19 wt % and even below 0.09 wt %. Obviously, there are cases where the desired nominal content is Owt % or nominal absence of the element as occurs with all optional elements for certain applications. It has been surprisingly found, that when a “proper geometrical design strategy” (as previously defined) is employed great results can be achieved by having a controlled level of % B in the LP which is intentional. In different embodiments, % B is kept above 1 ppm, above 11 ppm, above 21 ppm, above 31 ppm and even above 51 ppm. For some applications, it has been found that the final properties of the component, can be surprisingly improved by the usage of rather high % B contents in LP. In different embodiments, % B is kept above 61 ppm, above 111 ppm, above 221 ppm, above 0.06 wt %, above 0.12 wt %, above 0.26 wt % and even above 0.6 wt %. Even in some of those applications, an excessive content of % B ends up being detrimental. In different embodiments, % B is kept below 0.4 wt %, below 0.19 wt %, below 0.09 wt % and even below 0.04 wt %. For some applications, excessive % B seems to deteriorate the mechanical properties. In different embodiments, % B is kept below 400 ppm, below 190 ppm, below 90 ppm, below 40 ppm and even below 9 ppm. Obviously, there are cases where the desired nominal content is Owt % or nominal absence of the element as occurs with all optional elements for certain applications. For some applications, the presence of % Cr is desirable, while in other applications It is rather an impurity. In different embodiments, % Or is above 0.16 wt %, above 0.56 wt %, above 0.86 wt %, above 1.1 wt % and even above 1.6 wt %. For some applications, if very high thermal conductivity is required, it is often desirable to avoid an excessive % Cr content. In different embodiments, % Cr is below 2.1 wt %, below 1.7 wt %, below 1.3 wt % and even below 0.8 wt %. For some applications, lower % Cr contents are preferred. In different embodiments, % Cr is below 0.7 wt %, below 0.44 wt %, below 0.19 wt % and even below 0.09 wt %. Obviously, there are cases where the desired nominal content is Owt % or nominal absence of the element as occurs with all optional elements for certain applications. For some applications, the presence of % Ni is desirable, while in other applications It is rather an impurity. In different embodiments, % Ni is above 0.12 wt %, above 0.31 wt %, above 0.61 wt %, above 1.16 wt % and even above 1.7 wt %. For some applications, an excessive content of % Ni may adversely affect the mechanical properties. In different embodiments, % Ni is below 2.4 wt %, below 1.4 wt %, below 0.94 wt %, below 0.24 wt % and even below 0.1 wt %. Obviously, there are cases where the desired nominal content is Owt % or nominal absence of the element as occurs with all optional elements for certain applications. There are other elements that the inventor has found as strong or at least netto contributors to hardenability in the ferritic/perlitic domain which can be used in combination or as a replacement of % Ni. The most significant being % Cu and % Mn and to a lesser extent % Si. For some applications, the presence of % Si is desirable, while in other applications it is rather an impurity. In different embodiments, % Si is above 0.06 wt %, above 0.1 wt %, above 0.26 wt %, above 0.51 wt % and even above 0.76 wt %. For some applications, higher % Si contents are preferred. In different embodiments, % Si is above 1.1 wt %, above 1.4 wt %, above 1.6 wt %, above 1.8 wt % and even above 2.1 wt %. For some applications, excessive % Si seems to deteriorate the mechanical properties. In different embodiments, % Si is below 1.94 wt %, below 1.6 wt %, below 1.2 wt % and even below 0.84 wt %. For some applications, lower % Si contents are preferred. In different embodiments, % Si is below 0.64 wt %, below 0.49 wt %, below 0.24 wt % and even below 0.09 wt %. Obviously, there are cases where the desired nominal content is 0 wt % or nominal absence of the element as occurs with all optional elements for certain applications. For some applications, the presence of % Mn is desirable, while in other applications it is rather an impurity. In different embodiments, % Mn is above 0.1 wt %, above 0.26 wt %, above 0.56 wt %, above 0.86 wt % and even above 1.1 wt %. For some applications, an excessive content of % Mn may adversely affect the mechanical properties. In different embodiments, % Mn is below 2.4 wt %, below 1.7 wt %, below 1.2 wt %, below 0.94 wt % and even below 0.79 wt %. For some applications, lower % Mn contents are preferred. In different embodiments, % Mn is below 0.6 wt %, below 0.4 wt %, below 0.24 wt %, below 0.1 wt % and even below 0.04 wt %. Obviously, there are cases where the desired nominal content is 0 wt % or nominal absence of the element as occurs with all optional elements for certain applications. For some applications, the presence of % Co is desirable, while in other applications, it is rather an impurity. In different embodiments, % Co is above 0.06 wt %, above 0.12 wt %, above 0.26 wt %, above 0.51 wt % and even above 1.1 wt %. For some applications, excessive % Co seems to deteriorate the mechanical properties. In different embodiments, % Co is below 2.4 wt %, below 1.4 wt %, below 0.6 wt %, below 0.4 wt %, below 0.19 wt % and even below 0.02 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0006 wt %, above 0.09 wt %, above 0.12 wt %, above 0.16 wt % and even above 0.52 wt %. For some applications, excessive % Pb seems to deteriorate the mechanical properties. In different embodiments, % Pb is below 1.4 wt %, below 0.9 wt %, below 0.44 wt %, below 0.24 wt %, below 0.09 wt % and even below 0.02 wt %. Obviously, there are cases where the desired nominal content is Owt % or nominal absence of the element as occurs with all optional elements for certain applications. For some applications, the presence of % Bi is desirable, while in other applications it is rather an impurity. In different embodiments, % Bi is above 0.0002 wt %, above 0.06 wt %, above 0.1 wt %, above 0.14 wt % and even above 0.51 wt %. For some applications, excessive % Bi seems to deteriorate the mechanical properties. In different embodiments, % Bi is below 0.4 wt %, below 0.24 wt %, below 0.14 wt %, below 0.09 wt % and even below 0.01 wt %. Obviously, there are cases where the desired nominal content is Owt % or nominal absence of the element as occurs with all optional elements for certain applications. For some applications, the presence of % Se is desirable, while in other applications it is rather an impurity. In different embodiments, % Se is above 0.0006 wt %, above 0.05 wt %, above 0.12 wt %, above 0.16 wt % and even above 0.51 wt %. For some applications, excessive % Se seems to deteriorate the mechanical properties. In different embodiments, % Se is below 0.44 wt %, below 0.2 wt %, below 0.13 wt %, below 0.09 wt % and even below 0.009 wt %. Obviously, there are cases where the desired nominal content is 0 wt % or nominal absence of the element as occurs with all optional elements for certain applications. For some applications, the presence of % Hf is desirable, while in other applications it is rather an impurity. In different embodiments, % Hf is above 0.08 wt %, above 0.25 wt %, above 0.51 wt % and even above 0.76 wt %. The inventor has found that for applications requiring high toughness levels, the % Hf and/or % Zr content should not be very high, as they tend to form big and polygonal primary carbides which act as stress raisers. In different embodiments, % Hf is below 1.9 wt %, below 1.4 wt %, below 0.98 wt %, below 0.49 wt % and even below 0.4 wt %. For some applications, lower % Hf contents are preferred. In different embodiments, % Hf is below 0.24 wt %, below 0.12 wt %, below 0.08 wt % and even below 0.002 wt %. For some applications, where the presence of strong carbide formers is advantageous, but where manufacturing cost is of importance the presence of % Zr is desirable. In different embodiments, % Zr is above 0.06 wt %, above 0.1 wt %, above 0.16 wt % and even above 0.52 wt %. For some applications, excessive % Zr seems to deteriorate the mechanical properties. In different embodiments, % Zr is below 2.8 wt %, below 1.9 wt %, below 1.5 wt % and even below 0.94 wt % and even below 0.44 wt %. For some applications, lower % Zr contents are preferred. In different embodiments, % Zr is below 0.3 wt %, below 0.14 wt %, below 0.09 wt % and even below 0.004 wt %. In some embodiments. % Zr and/or % Hf can be partially or totally replaced by % Ta. In different embodiments, more than 26 wt % of the amount of % Hf and/or % Zr are replaced by % Ta, more than 56 wt % of the amount of % Hf and/or % Zr are replaced by % Ta and even more than 76 wt % of the amount of % Hf and/or % Zr are replaced by % Ta. In different embodiments, % Ta+% Zr is above 0.0009 wt %, above 0.009 wt %, above 0.01 wt % above 0.09 wt % and even above 0.11 wt %. For some applications, excessive % Ta+% Zr seems to deteriorate the mechanical properties. In different embodiments, % Ta+% Zr is below 2.4 wt %, below 0.94 wt %, below 0.44 wt % and even below 0.24 wt %. For some applications, when it comes to wear resistance the presence of % Hf and/or % Zr has a positive effect. If this is to be greatly increased, then other strong carbide formers like % Ta or even % Nb can also be used. In different embodiments. % Zr+% Hf+% Nb+% Ta is above 0.1 wt %, above 0.56 wt %, above 0.76 wt % and even above 1.1 wt %. For some applications, excessive % Zr+% Hf+% Nb+% Ta seems to deteriorate the mechanical properties. In different embodiments, % Zr+% Hf+% Nb+% Ta is below 1.9 wt %, below 0.94 wt %, below 0.4 wt % and even below 0.14 wt %. For some applications, the presence of % P is desirable, while in other applications, it is rather an impurity. In different embodiments, % P is above 0.0001 wt %, above 0.001 wt %, above 0.009 wt % above 0.01 wt % and even above 0.12 wt %. For some applications, % P should be kept as low as possible for high thermal conductivity. In different embodiments, % P is below 0.6 wt %, below 0.3 wt %, below 0.08 wt %, below 0.04 wt %, below 0.009 wt % and even below 0.004 wt %. For some applications, lower % P contents are preferred. In different embodiments, % P is below 0.0009 wt %, below 0.0007 wt % and even below 0.0004 wt %. Obviously, there are cases where the desired nominal content is Owt % or nominal absence of the element as occurs with all optional elements for certain applications. For some applications, the presence of % S is desirable, while in other applications, it is rather an impurity. In different embodiments, % S is above 0.006 wt %, above 0.02 wt %, above 0.1 wt % and even above 0.15 wt %. For some applications, % S should be kept as low as possible for high thermal conductivity. In different embodiments, % S is below 0.4 wt %, below 0.14 wt %, below 0.09 wt %, below 0.04 wt % and even below 0.009 wt %. For some applications, lower % S contents are preferred. In different embodiments, % S is below 0.0008 wt %, below 0.0006 wt %, below 0.0004 wt % and even below 0.0001 wt %. Obviously, there are cases where the desired nominal content is Owt % or nominal absence of the element as occurs with all optional elements for certain applications. For some applications, a certain content of % Mn+2*% Ni is desirable. In different embodiments, % Mn+2*% Ni is 0.06 wt % or more, 0.12 wt % or more, 0.21 wt % or more, 0.56 wt % or more, 0.76 wt % or more, 1.2 wt % or more, 1.56 wt % or more and even 2.16 wt % or more. For some applications, excessive % Mn+2*% Ni seems to deteriorate the mechanical properties. In different embodiments, % Mn+2*% Ni is 3.4 wt % or less, 2.9 wt % or less, 1.4 wt % or less, 1.2 wt % or less, 0.89 wt % or less, 0.74 wt % or less and even 0.48 wt % or less. Surprisingly enough, the controlled presence of % B seems to have a strong influence for some applications on the desirable level of % Mn+2*% Ni, some applications strongly benefiting from such presence and some on the contrary suffering from it. In different embodiments, when % B is present in a quantity above 12 ppm, % Mn+2*% Ni is kept above 0.01 wt %, above 0.06 wt %, above 0.16 wt %, above 0.26 wt %, above 0.46 wt %, above 086 wt % and even above 1.56 wt %. As said, some applications (including some applications involving heat transference) do not benefit from the concurrent presence of high levels of % Mn+2*% Ni and % B. In different embodiments, when % B is present in a quantity above 12 ppm, % Mn+2*% Ni is kept below 1.96 wt %, below 0.96 wt %, below 0.46 wt %, below 0.24 wt % and even below 0.09 wt %. For some applications, a certain content of % Cu+% Ni is desirable. In different embodiments, % Cu+% Ni is above 0.26 wt %, above 0.56 wt %, above 0.76 wt % and even above 1.1 wt %. For some applications, excessive % Cu+% Ni seems to deteriorate the mechanical properties. In different embodiments, % Cu+% Ni is below 3.9 wt %, below 2.4 wt %, below 1.4 wt % and even below 0.9 wt %. All the upper and lower limits disclosed above can be combined among them in any combination, provided that they are not mutually exclusive: for example, in an embodiment, % C=0−<0.39; or for example, in an embodiment, % Sc+% Y+% REE=0−<0.96, being % REE the sum of lanthanides and actinides; or for example, in an embodiment,% Mn+2*% Ni=0.06-3.4 wt % or for example, in an embodiment, % Mn+2*% Ni=0.21-1.2 wt %, Most applications benefit from the general size ranges for the larger powder stated above, but some applications benefit from a somewhat different size distribution. In different embodiments, the “powder size critical measure” (as previously defined) for LP is 2 microns or larger, 22 microns or larger, 42 microns or larger, 52 microns or larger, 102 microns or larger and even 152 microns or larger. For some applications, excessively large size critical measures are difficult to deal especially for some fine detail geometries. In different embodiments, the “powder size critical measure” (as previously defined) for LP is 1990 microns or smaller, 1490 microns or smaller, 990 microns or smaller, 490 microns or smaller, 290 microns or smaller, 190 microns or smaller and even 90 microns or smaller. For some applications it has been found that the manufacturing method for the larger powder has a remarkable influence in the attainable properties of the final component. In an embodiment, LP is a non-spherical powder (as previously defined). In an embodiment, the LP is water atomized. In another embodiment, the LP comprises water atomized powder. In an embodiment, LP is a spherical powder (as previously defined). In another embodiment, the LP is centrifugal atomized. In another embodiment, the LP comprises centrifugal atomized powder. In another embodiment, the LP is mechanically crushed. In another embodiment, the LP comprises crushed powder. In another embodiment, the LP is reduced. In another embodiment, the LP comprises reduced powder. In another embodiment, the LP is gas atomized. In another embodiment, the LP comprises gas atomized powder.

SP is a powder having the following composition, all percentages being indicated in weight percent: % Mo: 0-0.9; % W: 0-0.9; % Moeq: 0-0.9; % Ceq: 0-2.9; % C: 0-2.9; % N: 0-0.2; % B: 0-0.8; % Si: 0-0.9; % Mn: 0-1.9; % Ni: 0-2.9; % Mn+2*% Ni: 0-3.8; % Cr: 0-1.9; % V: 0-0.9; % Nb: 0-0.9; % Zr: 0-0.4; % Hf: 0-0.4; % Ta: 0-0.4; % S: 0-0.2: % P: 0-0.09; % Pb: 0-0.9; % Cu: 0-1.9; % Bi: 0-0.2; % Se: 0-0.2; % Co: 0-1.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq=% Mo+½*% W: and wherein % REE is as previously defined. In an embodiment, trace elements refers to several elements, unless context clearly indicates otherwise, including but not limited to H, He, Xe, F. Ne, Na, Cl, Ar, K, Br, Kr, Sr, Tc, Ru, Rh, Ti, Pd, Ag, I, Ba, Re, Os, Ir, Pt, Au, Hg, Tl, Po, At, Rn, Fr, Ra, Rf, Db, Sg, Bh, Hs, Li, Be, Mg, Ca, Rb, Zn, Cd, Al, Ga, In, Ge, Sn, Sb, As, Te, Ds, Rg, Cn, Nh, Fl, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the presence of % Y is desirable, while in other applications it is rather an impurity. In different embodiments, % Y is above 0.012 wt %, above 0.052 wt %, above 0.12 wt %, above 0.22 wt %, above 0.42 wt % and even above 0.82 wt %. For some applications, excessive % Y seems to deteriorate the mechanical properties. In different embodiments, % Y is below 0.74 wt %, below 0.48 wt %, below 0.34 wt %, below 0.18 wt % and even below 0.09 wt %. Obviously, there are cases where the desired nominal content is 0 wt % or nominal absence of the element as occurs with all optional elements for certain applications. For some applications, the presence of % Sc is desirable, while in other applications it is rather an impurity. In different embodiments, % Sc is above 0.012 wt %, above 0.052 wt %, above 0.12 wt %, above 0.22 wt %, above 0.42 wt % and even above 0.82 wt %. For some applications, excessive % Sc seems to deteriorate the mechanical properties. In different embodiments, % Sc is below 0.74 wt %, below 0.48 wt %, below 0.34 wt % and even below 0.18 wt %. Obviously, there are cases where the desired nominal content is Owt % or nominal absence of the element as occurs with all optional elements for certain applications. For some applications, a certain content of % Sc+% Y is desirable. In different embodiments, % Sc+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt %. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, excessive % REE seems to deteriorate the mechanical properties. In different embodiments, % REE is below 1.4 wt %, below 0.96 wt %, below 0.74 wt % and even below 0.48 wt %. Obviously, there are cases where the desired nominal content is Owt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments, % Sc+% Y+% REE is below 1.4 wt %, below 0.96, below 0.74 wt % and even below 0.48 wt %. In some embodiments, the above disclosed for the content of % O, % Cs, % Y, % Sc, % REE and/or % Ti can also be applied to the composition of SP. For some applications, the relation between the atomic content of % O and % Y+% Sc or alternatively % Y or alternatively % Y+% Sc+% REE has to be controlled for optimum mechanical properties according to the formulas previously disclosed. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, excessive % O≤eems to deteriorate the mechanical properties. In different embodiments, % O is below 2990 ppm, below 1900 ppm, below 900 ppm and even below 490 ppm. Obviously, there are cases where the desired nominal content is Owt % or nominal absence of the element as occurs with all optional elements for certain applications. For some applications, the presence of % C is desirable, while in other applications it is rather an impurity. In different embodiments, % C is above 0.001 wt %, above 0.02 wt %, above 0.07 wt %, above 0.1 wt % and even above 0.12 wt %. For some applications, particularly when increasing carbide formers content, also % C has to be increased in order to combine with those elements. In different embodiments, % C is above 0.14 wt %, above 0.16 wt %, above 0.21 wt %, above 0.26 wt % above 0.28 wt % and even above 0.56 wt %. For applications requiring improved wear resistance even higher % C contents are preferred. In different embodiments, % C is above 0.66 wt %, above 1.1 wt %, above 1.52 wt % and even above 1.9 wt %. For some applications, an excessive content of % C may adversely affect the mechanical properties. In different embodiments, % C is below 1.94 wt %, below 1.48 wt %, below 1.44 wt % and even below 0.94 wt %. For some applications, lower % C contents are preferred. In different embodiments, % C is below 0.7 wt %, below 0.32 wt %, below 0.28 wt %, below 0.23 wt %, below 0.14 wt % and even below 0.04 wt %. Obviously, there are cases where the desired nominal content is Owt % or nominal absence of the element as occurs with all optional elements for certain applications. For some applications, the presence of % Ceq is desirable, while in other applications it is rather an impurity. In different embodiments, % Ceq is above 0.001 wt %, above 0.06 wt %, above 0.1 wt %, above 0.21 wt % and even above 0.23 wt %. The inventor has found that for some applications requiring good wear resistance in combination with high toughness within the present invention, higher % Ceq contents are preferred. In different embodiments, % Ceq is above 0.26 wt %, above 0.29 wt %, above 0.31 wt and even above 0.51 wt %. For some applications, even higher % Ceq contents are preferred. In different embodiments, % Ceq is above 0.61 wt %, above 0.91 wt %, above 1.3% and even above 1.8 wt %. On the other hand, for some applications, too high levels of % Ceq lead to impossibility to attain the required nature and perfection of carbides (nitrides, borides, oxides or combinations) regardless of the heat treatment applied. In different embodiments, % Ceq is below 2.3 wt %, below 1.9 wt %, below 1.4 wt %, below 1.2 wt % and even below 0.9 wt %. For some applications, lower % Ceq contents are preferred. In different embodiments, % Ceq is less than 0.49 wt %, less than 0.34 wt %, less than 0.29 wt %, less than 0.24 wt %, less than 0.13 wt % and even less than 0.07 wt %. Obviously, there are cases where the desired nominal content is Owt % or nominal absence as occurs with all optional elements for certain applications. For some applications, the presence of % N is desirable, while in other applications it is rather an impurity. In different embodiments, % N is above 0.0002 wt %, above 0.0009 wt %, above 0.002 wt %, above 0.008 wt % and even above 0.02 wt %. For some applications, higher % N contents are preferred. In different embodiments, % N is above 0.07 wt %, above 0.08 wt % above 0.096 wt %, above 0.11 wt % and even above 0.12 wt %. For some applications, excessive % N seems to deteriorate the mechanical properties. In different embodiments, % N is below 0.19 wt %, below 0.15 wt %, below 0.08 wt %, below 0.02 wt % and even below 0.002 wt %. Obviously, there are cases where the desired nominal content is Owt % or nominal absence of the element as occurs with all optional elements for certain applications. For some applications, the presence of % Mo is desirable, while in other applications it is rather an impurity. In different embodiments, % Mo is above 0.001 wt %, above 0.1 wt %, above 0.16 wt %, above 0.26 wt % and even above 0.31 wt %. For some applications, higher % Mo contents are preferred for high thermal conductivity. In different embodiments, % Mo is above 0.36 wt %, above 0.41 wt %, above 0.48 wt % and even above 0.51 wt %. For some applications, excessive % Mo seems to deteriorate the mechanical properties. In different embodiments, % Mo is below 0.74 wt %, below 0.59 wt %, below 0.49 wt %, below 0.29 wt %, below 0.24 wt % and even below 0.1 wt %. Obviously, there are cases where the desired nominal content is Owt % or nominal absence of the element as occurs with all optional elements for certain applications. In some embodiments, % Mo can be partially replaced with % W. This replacement takes place in terms of % Moeq. In different embodiments, the replacement of % Mo with % W is lower than 69 wt %, lower than 54 wt %, lower than 34 wt % and even lower than 12 wt %. For applications where thermal conductivity is to be maximized but thermal fatigue has to be regulated, it is normally preferred to have from 1.2 to 3 times more % Mo than % W, but not absence of % W. For some applications, the presence of % Moeq is desirable, while in other applications, it is rather an impurity. In different embodiments, % Moeq is above 0.009 wt %, above 0.06 wt %, above 0.16 wt %, above 0.3 wt %, above 0.46 wt % and even above 0.6 wt %. On the other hand, too high levels of % Moeq will lead to situations where thermal conductivity can be negatively affected. In different embodiments, % Moeq is below 0.84 wt %, below 0.74 wt %, below 0.59 wt %, below 0.4 wt % and even below 0.29 wt %. For some applications, lower % Moeq contents are preferred. In different embodiments, % Moeq is below 0.24 wt %, below 0.1 wt % k and even below 0.09 wt %. Obviously, there are cases where the desired nominal content is Owt % or nominal absence as occurs with all optional elements for certain applications. For some applications, the presence of % W is desirable, while in other applications it is rather an impurity. In different embodiments, % W is above 0.001 wt %, above 0.03 wt %, above 0.1 wt %, above 0.26 wt % and even above 0.36 wt %. For some applications, an excessive content of % W may adversely affect the mechanical properties. In different embodiments, % W is below 0.84 wt %, below 0.64 wt % and even below 0.49 wt %. For some applications, lower % W contents are preferred. In different embodiments, % W is below 0.38 wt %, below 0.24 wt %, below 0.09 wt % or even no intentional % W at all. Obviously, there are cases where the desired nominal content is Owt % or nominal absence of the element as occurs with all optional elements for certain applications. For some applications, the presence of % V is desirable, while in other applications it is rather an impurity. In different embodiments, % V is above 0.001 wt %, above 0.04 wt %, above 0.09 wt %, above 0.16 wt % and even above 0.26 wt %. On the other hand, for some applications, excessive % V seems to deteriorate the mechanical properties. In different embodiments, % V is below 0.8 wt %, below 0.6 wt %, below 0.4 wt % and even below 0.3 wt %. For some applications, lower % V contents are preferred. In different embodiments, % V is below 0.24 wt %, below 0.14 wt %, below 0.09 wt % and even below 0.009 wt %. Obviously, there are cases where the desired nominal content is Owt % or nominal absence of the element as occurs with all optional elements for certain applications. The inventor has surprisingly found that for some applications, small amounts of % B have a positive effect on increasing thermal conductivity. In different embodiments, % B is above 2 ppm, above 16 ppm, above 61 ppm and even above 86 ppm. The inventor has found that for some applications, in order to have a noticeable effect on the attainable bainitic microstructure, % B has to be present in somewhat higher contents that what is required for the increase of the hardenability in the ferrite/perlite domain. In different embodiments, % B is above 90 ppm, above 126 ppm, above 206 ppm and even above 326 ppm. For some applications, higher % B contents are preferred. In different embodiments, % B is above 0.09 wt %, above 0.11 wt %, above 0.26 wt % and even above 0.4 wt %. On the other hand, the effect on the toughness can be quite detrimental if excessive borides are formed. In different embodiments, % B is below 0.74 wt %, below 0.6 wt %, below 0.4 wt %, below 0.24 wt % and even below 0.12 wt %. For some applications, lower % B contents are preferred. In different embodiments, % B is below 740 ppm, below 490 ppm, below 140 ppm, below 80 ppm and even below 40 ppm. Obviously, there are cases where the desired nominal content is Owt % or nominal absence of the element as occurs with all optional elements for certain applications. For some applications, the presence of % Cr is desirable, while in other applications it is rather an impurity. In different embodiments, % Cr is above 0.0009 wt %, above 0.1 wt %, above 0.56 wt %, above 0.86 wt %, above 1.1 wt % and even above 1.6 wt %. For some applications, if very high thermal conductivity is required, it is often desirable to avoid an excessive % Cr content. In different embodiments, % Cr is below 1.8 wt %, below 1.6 wt %, below 1.4 wt % and even below 0.9 wt %. For some applications, lower % Cr contents are preferred. In different embodiments, % Cr is below 0.6 wt %, below 0.4 wt %, below 0.14 wt % and even below 0.08 wt %. Obviously, there are cases where the desired nominal content is Owt % or nominal absence of the element as occurs with all optional elements for certain applications. For some applications, the presence of % Ni is desirable, while in other applications it is rather an impurity. In different embodiments, % Ni is above 0.001 wt %, above 0.1 wt %, above 0.26 wt %, above 0.51 wt %, above 1.1 wt % and even above 1.6 wt %. For some applications, an excessive content of % Ni may adversely affect the mechanical properties. In different embodiments, % Ni is below 1.9 wt %, below 1.2 wt %, below 0.94 wt %, below 0.44 wt % below 0.14 wt % and even below 0.009 wt %. Obviously, there are cases where the desired nominal content is Owt % or nominal absence of the element as occurs with all optional elements for certain applications. There are other elements that the inventor has found as strong or at least netto contributors to hardenability in the ferritic/perlitic domain which can be used in combination or as a replacement of % Ni, the most significant being % Cu and % Mn and to a lesser extent % Si. For some applications, the presence of % Si is desirable, while in other applications it is rather an impurity. In different embodiments, % Si is above 0.0009 wt %, above 0.09 wt %, above 0.16 wt %, above 0.31 wt %, above 0.56 wt % and even above 0.71 wt %. For some applications, an excessive content of % Si may adversely affect the mechanical properties. In different embodiments, % Si is below 0.8 wt %, below 0.6 wt %, below 0.44 wt %, below 0.2 wt % and even below 0.09 wt %. Obviously, there are cases where the desired nominal content is Owt % or nominal absence of the element as occurs with all optional elements for certain applications. For some applications, the presence of % Mn is desirable, while in other applications it is rather an impurity. In different embodiments, % Mn is above 0.001 wt %, above 0.02 wt %, above 0.16 wt %, above 0.36 wt %, above 0.56 wt % and even above 1.2 wt %. For some applications, excessive % Mn seems to deteriorate the mechanical properties. In different embodiments, % Mn is below 1.6 wt %, below 1.4 wt %, below 1.1 wt %, below 0.9 wt % and even below 0.7 wt %. For some applications, lower % Mn contents are preferred. In different embodiments, % Mn is below 0.5 wt %, below 0.3 wt %, below 0.14 wt %, below 0.09 wt % and even below 0.04 wt %. Obviously, there are cases where the desired nominal content is Owt % or nominal absence of the element as occurs with all optional elements for certain applications. For some applications, the presence of % Co is desirable, while in other applications it is rather an impurity. In different embodiments, % Co is above 0.0009 wt %, above 0.05 wt %, above 0.12 wt %, above 0.21 wt %, above 0.56 wt % and even above 1 wt %. For some applications, excessive % Co seems to deteriorate the mechanical properties. In different embodiments, % Co is below 1.2 wt %, below 0.4 wt %, below 0.2 wt %, below 0.09 wt % below 0.01 wt % and even below 0.004 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0002 wt %, above 0.06 wt %, above 0.09 wt %, above 0.1 wt % and even above 0.56 wt %. For some applications, excessive % Pb seems to deteriorate the mechanical properties. In different embodiments, % Pb is below 0.6 wt %, below 0.4 wt %, below 0.1 wt %, below 0.09 wt % below 0.04 wt % and even below 0.0009 wt %. Obviously, there are cases where the desired nominal content is Owt % or nominal absence of the element as occurs with all optional elements for certain applications. For some applications, the presence of % Bi is desirable, while in other applications it is rather an impurity. In different embodiments, % Bi is above 0.0009 wt %, above 0.02 wt %, above 0.09 wt % and even above 0.1 wt %. For some applications, excessive % Bi seems to deteriorate the mechanical properties. In different embodiments, % Bi is below 0.14 wt %, below 0.1 wt %, below 0.09 wt %, below 0.009 wt % and even below 0.001 wt %. Obviously, there are cases where the desired nominal content is Owt % or nominal absence of the element as occurs with all optional elements for certain applications. For some applications, the presence % Se is desirable, while in other applications it is rather an impurity. In different embodiments, % Se is above 0.0001 wt %, above 0.005 wt %, above 0.02 wt %, above 0.08 wt % and even above 0.1 wt %. For some applications, excessive % Se seems to deteriorate the mechanical properties. In different embodiments, % Se is below 0.12 wt %, below 0.07 wt %, below 0.009 wt % and even below 0.0009 wt %. Obviously, there are cases where the desired nominal content is Owt % or nominal absence of the element as occurs with all optional elements for certain applications. For some applications, where the presence of strong carbide formers is advantageous, but where manufacturing cost is of importance the presence of % Zr is desirable. In different embodiments, % Zr is above 0.006 wt %, above 0.06 wt %, above 0.1 wt % and even above 0.12 wt %. The inventor has found that for applications requiring high toughness levels, the % Hf and/or % Zr content should not be very high, as they tend to form big and polygonal primary carbides which act as stress raisers. In different embodiments, % Zr is below 0.28 wt %, below 0.18 wt %, below 0.13 wt %, below 0.08 wt % and even below 0.03 wt %. For some applications, the presence of % Hf is desirable, while in other applications it is rather an impurity. In different embodiments, % Hf is above 0.008 wt %, above 0.05 wt %, above 0.09 wt % and even above 0.11 wt %. For some applications, an excessive content of % Hf may adversely affect the mechanical properties. In different embodiments, % Hf is below 0.29 wt %, below 0.19 wt %, below 0.14 wt %, below 0.09 wt % and even below 0.04 wt %. For some applications, % Zr and/or % Hf can be partially or totally replaced by % Ta. In different embodiments, more than 25 wt % of the amount of % Hf and/or % Zr are replaced by % Ta, more than 50 wt % of the amount of % Hf and/or % Zr are replaced by % Ta and even more than 75 wt % of the amount of % Hf and/or % Zr are replaced by % Ta. In different embodiments, % Ta+% Zr is above 0.0009 wt %, above 0.009 wt %, above 0.01 wt % above 0.09 wt % and even above 0.11 wt %. For some applications, excessive % Ta+% Zr seems to deteriorate the mechanical properties. In different embodiments, % Ta+% Zr is below 0.4 wt % below 0.18 wt % and even below 0.004 wt %. For some applications, when it comes to wear resistance the presence of % Hf and/or % Zr has a positive effect. If this is to be greatly increased, then other strong carbide formers like % Ta or even % Nb can also be used. In different embodiments, % Zr+% Hf+% Nb+% Ta is above 0.001 wt %, above 0.1 wt %, above 0.36 wt %, above 0.46 wt % and even above 0.76 wt %. For some applications, excessive % Zr+% Hf+% Nb+% Ta seems to deteriorate the mechanical properties. In different embodiments, % Zr+% Hf+% Nb+% Ta is below 0.9 wt %, below 0.46 wt %, below 0.34 wt % below 0.16 wt % and even below 0.001 wt %. For some applications, the presence of % P is desirable, while in other applications, it is rather an impurity. In different embodiments, % P is above 0.0001 wt %, above 0.001 wt %, above 0.008 wt % and even above 0.01 wt %. For some applications, % P and/or % S should be kept as low as possible for high thermal conductivity. In different embodiments, % P is below 0.08 wt %, below 0.04 wt %, below 0.02 wt % and even below 0.002 wt %. Obviously, there are cases where the desired nominal content is Owt % or nominal absence of the element as occurs with all optional elements for certain applications. For some applications, the presence of % S is desirable, while in other applications, it is rather an impurity. In different embodiments, % S is above 0.006 wt %, above 0.016 wt %, above 0.12 wt % and even above 0.18 wt %. For some applications, an excessive content of % S may adversely affect the mechanical properties. In different embodiments, % S is below 0.14 wt %, below 0.08 wt %, below 0.04 wt %, below 0.03 wt %, below 0.01 wt % and even below 0.001 wt %. Obviously, there are cases where the desired nominal content is Owt % or nominal absence of the element as occurs with all optional elements for certain applications. For some applications, a certain content of % Mn+2*% Ni is desirable. In different embodiments, % Mn+2*% Ni is 0.08 wt % or more, 0.16 wt % or more, 0.23 wt % or more, 0.58 wt % or more, 0.81 wt % or more, 1.26 wt % or more, 1.56 wt % or more and even 2.16 wt % or more. For some applications, excessive % Mn+2*% Ni seems to deteriorate the mechanical properties. In different embodiments, % Mn+2*% Ni is 3.2 wt % or less, 2.7 wt % or less, 1.6 wt % or less, 1.26 wt % or less, 0.78 wt % or less, 0.69 wt % or less 0.44 wt % and even 0.09 wt % or less. All the upper and lower limits disclosed in the different embodiments can be combined among them in any combination, provided that they are not mutually exclusive, for example: in an embodiment % Mn+2*% Ni=0.08-3.2 wt %; or for example in another embodiment % Mn+2*% Ni=0.23-1.26 wt %. For some applications, a certain content of % Cu+% Ni is desirable. In different embodiments, % Cu+% Ni is above 0.001 wt %, above 0.16 wt %, above 0.36 wt %, above 0.51 wt % and even above 0.66 wt %. For some applications, excessive % Cu+% Ni seems to deteriorate the mechanical properties. In different embodiments, % Cu+% Ni is below 2.4 wt %, below 1.4 wt %, below 0.9 wt %, below 0.4 wt % and even below 0.09 wt %. All the upper and lower limits disclosed above can be combined among them in any combination, provided that they are not mutually exclusive. For some applications, it works even better when the SP has a composition similar to that of the LP. In an embodiment, LP and SP are the same powder. In an embodiment, the SP has a composition falling inside the compositional range described above for LP. In an embodiment LP and SP have the same composition. In an embodiment. SP is spherical (as previously defined). In an embodiment. SP is a gas atomized powder. In an embodiment, SP comprises powder atomized with a system comprising gas atomization. In an embodiment, SP is a centrifugal atomized powder. In an embodiment, SP comprises powder atomized with a system comprising centrifugal atomization. In an embodiment, SP is a gas carbonyl powder. In an embodiment, SP comprises powder obtained through the carbonyl process. In an embodiment, SP is a powder obtained by oxide reduction. In an embodiment SP is a reduced powder. In an embodiment, SP is a carbonyl iron powder. In an embodiment, SP comprises a carbonyl iron powder. In an embodiment, SP is a non-spherical powder (as previously defined). Although, for most applications the general rules described above for SP apply, in some concrete applications, it is better to use somewhat different size constraints for SP of the present composition. In different embodiments, the “powder size critical measure” (as previously defined) for SP is 0.6 nanometers or larger, 52 nanometers or larger, 602 nanometers or larger, 1.2 microns or larger, 6 microns or larger, 12 microns or larger and even 32 microns or larger. For some applications, excessively large size critical measures are difficult to deal especially for some fine detail geometries. In different embodiments, the “powder size critical measure” (as previously defined) for SP is 990 microns or smaller, 490 microns or smaller, 190 microns or smaller, 90 microns or smaller, 19 microns or smaller, 9 microns or smaller, 890 nanometers or smaller and even 490 nanometers or smaller.

In an embodiment, the mixture of SP and LP further comprises a powder AP1 with the following composition:

AP1 is a powder having the following composition, all percentages being indicated in weight percent: % Moeq: 40-99.999; % Mo: 0-99.999; % W: 0-99.9; % Ceq: 0-2.99; % C: 0-2.99; % N: 0-2.2; % B: 0-2.9; % O: 0-8; % Cr: 0-9; % V: 0-5; % Mn+% Ni+% Si: 0-12; the rest consisting of iron and trace elements: wherein % Ceq=% C+0.86*% N+1.2*% kB and % Moeq=% Mo+½*W. In an embodiment, trace elements refers to several elements, unless context clearly indicates otherwise, including but not limited to H, He, Xe, F, S, P, Pb, Cu, Co, Ta, Zr, Nb, Hf, Cs, Y, Sc, Ne, Na, Cl, Ar, K, Br, Kr, Sr, Tc, Ru, Rh, Pd, Ag, I, Ba, Re, Os, Ir, Ti, Pt, Au, Hg, Tl, Po, At, Rn, Fr, Ra, Ac, Th, Pa, U, Np, Pu, Am, Cm, Bk, Cf, Es, Fm, Md, No, Lr, La, Ce, Pr, Nd, Pm, Sm, Eu, Gd, Th, Dy, Ho, Er, Tm, Yb, Lu, Rf, Db, Sg, Bh, Hs, Li, Be, Mg, Ca, Rb, Zn, Cd, Al, Ga, In, Ge, Sn, Bi, Sb, As, Se, Te, Ds, Rg, Cn, Nh, Fl, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. In an embodiment, AP1 is not present. In an embodiment, the % of AP1 present is a function of % Moeq present, that is to say the values given for % of AP1 refer to the value the % Moeq of AP1 contributes and thus the real content of % AP1 is higher. In different embodiments, % Mo is 52 wt % or higher, 56 wt % or higher, 61 wt % or higher, 71 wt % or higher, 81 wt % or higher and even 91 wt % or higher. For some applications, an excessive content of % Mo may adversely affect the mechanical properties. In different embodiments, % Mo is less than 84 wt %, less than 74 wt %, less than 54 wt %, less than 39 wt % and even less than 24 wt %. Obviously, there are cases where the desired nominal content is Owt % or nominal absence of the element as occurs with all optional elements for certain applications. In different embodiments, % Moeq is 51 wt % or higher, 53 wt % or higher, 57 wt % or higher, 63 wt % or higher, 72 wt % or higher, 82 wt % or higher and even 93 wt % or higher. For some applications, an excessive content of % Moeq may adversely affect the mechanical properties. In different embodiments, % Moeq is less than 89 wt %, less than 79 wt %, less than 69 wt %, less than 59 wt % and even less than 49 wt %. For some applications, the presence of % W is desirable, while in other applications it is rather an impurity. In different embodiments, % W is 0.011 wt % or more, 1.6 wt % or more, 6.1 wt % or more, 21.6 wt % or more and even 51 wt % or more. For some applications, excessive % W seems to deteriorate the mechanical properties. In different embodiments, % W is below 84 wt %, below 44 wt %, below 24 wt %, below 9 wt % and even below 4.9 wt %. Obviously, there are cases where the desired nominal content is Owt % or nominal absence of the element as occurs with all optional elements for certain applications. For some applications, a certain content of % Mn+% Ni+% Si is desirable. In different embodiments, % Mn+% Ni+% Si is 0.001 wt % or more, 0.12 wt % or more, 0.8 wt % or more, 1.58 wt % or more, 2.6 wt % or more, 3.26 wt % or more, 4.56 wt % or more and even 6.16 wt % or more. For some applications, excessive % Mn+% Ni+% Si seems to deteriorate the mechanical properties. In different embodiments, % Mn+% Ni+% Si is below 6.4 wt %, below 3.4 wt %, below 1.9 wt %, below 0.4 wt % and even below 0.09 wt %. For some applications, the presence of % Ceq is desirable, while in other applications, it is rather an impurity. In different embodiments, % Ceq is above 0.01 wt %, above 0.21 wt %, above 0.51 wt %, above 1.2 wt % and even above 1.6 wt %. For some applications, an excessive content of % Ceq may adversely affect the mechanical properties. In different embodiments, % Ceq is below 2.5 wt %, below 1.9 wt %, below 1.4 wt %, below 0.9 wt % and even below 0.4 wt %. Obviously, there are cases where the desired nominal content is Owt % or nominal absence as occurs with all optional elements for certain applications. For some applications, the presence of % C is desirable, while in other applications it is rather an impurity. In different embodiments, % C is 0.006 wt % or more, 0.01 wt % or more, 0.11 wt % or more, 0.56 wt % or more and even 1.16 wt % or more. For some applications, an excessive content of % C may adversely affect the mechanical properties. In different embodiments, % C is below 2.49 wt %, below 1.89 wt %, below 1.39 wt %, below 0.89 wt % and even below 0.39 wt %. Obviously, there are cases where the desired nominal content is Owt % or nominal absence of the element as occurs with all optional elements for certain applications. For some applications, the presence of % N is desirable, while in other applications it is rather an impurity. In different embodiments, % N is 0.009 wt % or more, 0.21 wt % or more, 0.41 wt % or more, 1.1 wt % or more and even 1.56 wt % or more. For some applications, excessive % N seems to deteriorate the mechanical properties. In different embodiments, % N is below 1.49 wt %, below 0.89 wt %, below 0.39 wt %, below 0.14 wt % and even below 0.09 wt %. Obviously, there are cases where the desired nominal content is Owt % or nominal absence of the element as occurs with all optional elements for certain applications. For some applications, the presence of % B is desirable, while in other applications it is rather an impurity. In different embodiments, % B is 0.0009 wt % or more, 0.01 wt % or more, 0.31 wt % or more, 1.06 wt % or more and even 1.56 wt % or more. For some applications, excessive % B seems to deteriorate the mechanical properties. In different embodiments, % B is below 1.9 wt %, below 0.79 wt %, below 0.29 wt %, below 0.1 wt % and even below 0.09 wt %. Obviously, there are cases where the desired nominal content is Owt % or nominal absence of the element as occurs with all optional elements for certain applications. For some applications, the presence of % O is desirable, while in other applications it is rather an impurity. In different embodiments, % O is 0.0006 wt % or more, 0.001 wt % or more, 0.12 wt % or more, 1.26 wt % or more and even 1.6 wt % or more. For some applications, higher % O contents are preferred. In different embodiments, % O is 2.1 wt % or more, 2.56 wt % or more, 3.12 wt % or more, 4.1 wt % or more and even 5.1 wt % or more. For some applications, excessive % O≤eems to deteriorate the mechanical properties. In different embodiments, % O is below 4.9 wt %, below 0.79 wt %, below 0.29 wt %, below 0.1 wt % and even below 0.09 wt %. For some applications, lower % O contents are preferred. In different embodiments, % O is below 149 ppm, below 99 ppm, below 49 ppm, below 29 ppm and even below 4 ppm. Obviously, there are cases where the desired nominal content is Owt % or nominal absence of the element as occurs with all optional elements for certain applications. For some applications, the presence of % Cr is desirable, while in other applications it is rather an impurity. In different embodiments, % Cr is 0.1 wt % or more, 0.51 wt % or more, 0.81 wt % or more, 1.21 wt % or more and even 1.56 wt % or more. For some applications, higher % Cr contents are preferred. In different embodiments, % Cr is 2.1 wt % or more, 2.51 wt % or more, 3.1 wt % or more, 4.1 wt % or more and even 6.1 wt % or more. For some applications, excessive % Cr seems to deteriorate the mechanical properties. In different embodiments, % Cr is below 7.9 wt %, below 5.9 wt %, below 4.4 wt %, below 3.1 wt % and even below 2.49 wt %. For some applications, lower % Cr contents are preferred. In different embodiments, % Cr is below 1.89 wt %, below 1.49 wt %, below 0.98 wt %, below 0.19 wt % and even below 0.1 wt %. Obviously, there are cases where the desired nominal content is Owt % or nominal absence of the element as occurs with all optional elements for certain applications. For some applications, the presence of % V is desirable, while in other applications it is rather an impurity. In different embodiments, % V is 0.0006 wt % or more, 0.01 wt % or more, 0.21 wt % or more, 0.81 wt % or more and even 1.06 wt % or more. For some applications, excessive % V seems to deteriorate the mechanical properties. In different embodiments, % V is below 3.9 wt %, below 2.9 wt %, below 1.4 wt %, below 0.89 wt % and even below 0.39 wt %. Obviously, there are cases where the desired nominal content is Owt % or nominal absence of the element as occurs with all optional elements for certain applications. For some applications, the correct choosing of AP1 size is important. In different embodiments, the “powder size critical measure” (as previously defined) for AP is 0.6 nanometers or larger, 2 nanometers or larger, 52 nanometers or larger, 202 nanometers or larger, 602 nanometers or larger, 1.2 microns or larger and even 32 microns or larger. For some applications, excessively large size critical measures are difficult to deal especially for some fine detail geometries. In different embodiments, the powder size critical measure (as previously defined) for AP1 is 990 microns or smaller, 490 microns or smaller, 190 microns or smaller, 90 microns or smaller, 19 microns or smaller, 9 microns or smaller, 890 nanometers or smaller and even 490 nanometers or smaller. For some applications, the composition of the powder AP1 as defined in any of the embodiments above can be advantageously added to other powder mixtures disclosed throughout in this document, and particularly to each and any one of the mixtures LP and SP described throughout the present document. Accordingly, all the embodiments disclosed above can be combined among them and with any other embodiment disclosed in this document that relates to a powder AP1 in any combination, provided that they are not mutually exclusive.

In an embodiment, the mixture of SP and LP further comprises a powder AP2. In an embodiment, there is also a powder AP2 with a high % C content. In an embodiment, the % C content of AP2 is at least 33 wt %. In an embodiment, the % C content of AP2 is at least 66 wt %. In an embodiment, the % C content of AP2 is at least 86 wt %. In an embodiment, the % C content of AP2 is at least 93 wt %. In an embodiment, AP2 is % C and trace elements. In an embodiment, the % C of AP2 is constituted to at least 52% graphite. In an embodiment, the % C of AP2 is constituted to at least 52% synthetic graphite. In an embodiment, the % C of AP2 is constituted to at least 52% natural graphite. In an embodiment, the % C of AP2 is constituted to at least 52% of fullerene carbon. In an embodiment, AP2 is not present. In an embodiment, what has been said about AP1 for the powder size critical measure applies also to AP2. In an embodiment, AP2 comprises % C and trace elements. In an embodiment, trace elements refers to several elements, unless context clearly indicates otherwise, including but not limited to H, He. Xe, F, S, P, B, Mo, W, N, Si, Mn, Ni, Cr, V, Pb, Cu, Co, Fe, O, Ta, Zr, Nb, Hf, Cs, Y, Sc, Ne, Na, Cl, Ar, K, Br, Kr, Sr, Tc, Ru. Rh, Pd, Ag, I, Ba, Re, Os, Ir, Ti, Pt, Au, Hg, Tl, Po, At, Rn, Fr, Ra, Ac, Th, Pa, U, Np, Pu, Am, Cm, Bk. Cf, Es, Fm, Md, No, Lr, La, Ce, Pr, Nd, Pm, Sm. Eu, Gd, Tb, Dy, Ho, Er, Tm, Yb, Lu, Rf, Db, Sg, Bh. Hs, Li, Be, Mg, Ca, Rb. Zn, Cd, Al, Ga, In, Ge, Sn, Bi, Sb. As, Se, Te, Ds, Rg, Cn, Nh, FI, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the composition of the powder AP2 as defined in any of the embodiments above can be advantageously added to other powder mixtures disclosed throughout in this document, and particularly to each and any one of the mixtures LP and SP described throughout the present document. Accordingly, all the embodiments disclosed above can be combined among them and with any other embodiment disclosed in this document that relates to a powder AP2 in any combination, provided that they are not mutually exclusive. In An embodiment, AP2 comprises a carbonyl iron powder. In different embodiments the volume percentage of carbonyl iron powder in the powder mixture is 10 vol % or more, 20% or more and even 30 vol % or more. For certain application, the volume percentage of carbonyl iron powder in the mixture should be controlled. In different embodiments, the volume percentage of carbonyl iron powder in the powder mixture is 60 vol % or less, 50 vol % or less, 40 vol % or less and even 30 vol % or less.

In an embodiment, the mixture of SP and LP further comprises a powder AP3.

AP3 is a powder having the following composition, all percentages being indicated in weight percent: % Mn+% Ni+% Si: 22-99.999; % Moeq: 0-9.0; % Mo: 0-9.0; % W: 0-9.0; % % Ceq: 0-2.99; % C: 0-2.99; % N: 0-2.2; % B: 0-2.9; % O: 0-8; % Cr: 0-9; % V: 0-5; the rest consisting of iron and trace elements: wherein % Ceq=% C+0.86*% N+1.2*% B and % Moeq=% Mo+½*% W. In an embodiment, trace elements refers to several elements, unless context clearly indicates otherwise, including but not limited to H, He, Xe, F, S, P, Cu, Pb, Co, Ta, Zr, Nb, Hf, Cs, Y, Sc, No. Na, Cl, Ar, K, Br, Kr, Sr, Tc, Ru, Rh, Ti, Pd, Ag, I, Ba, Re, Os, Ir, Pt, Au, Hg, Tl, Po, At, Rn, Fr, Ra, Ac, Th, Pa, U, Np, Pu, Am, Cm, Bk, Cf, Es, Fm, Md, No, Lr, La, Ce, Pr, Nd, Pm, Sm, Eu, Gd, Th, Dy, Ho, Er, Tm, Yb, Lu, Rf, Db, Sg, Bh, Hs, Li, Be, Mg, Ca, Rb, Zn, Cd, Al, Ga, In, Ge, Sn, Bi, Sb, As, Se, Te, Ds, Rg, Cn, Nh, Fl, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. In an embodiment, AP3 is not present. In an embodiment, the % of AP3 present is a function of % Moeq present, that is to say the values given for % of AP3 refer to the value the % Moeq of AP3 contributes and thus the real content of % AP3 is higher. For some applications, the presence of % Mo is desirable, while in other applications it is rather an impurity. In different embodiments, % Mo is 0.009 wt % or higher, 1.2 wt % or higher, 2.6 wt % or higher, 3.1 wt % or higher. For some applications higher % Mo contents are preferred. In different embodiments, % Mo is 4.1 wt % or higher, 5.1 wt % or higher and even 7.1 wt % or higher. For some applications, excessive % Mo seems to deteriorate the mechanical properties. In different embodiments, % Mo is below 7.9 wt %, below 4.9 wt %, below 3.4 wt %, below 2.49 wt %, below 1.4 wt % and even below 0.89 wt %. Obviously, there are cases where the desired nominal content is Owt % or nominal absence of the element as occurs with all optional elements for certain applications. For some applications, higher contents of % Mn+% Ni+% Si are preferred. In different embodiments, % Mn+% Ni+% Si is 31 wt % or higher, 42 wt % or higher, 51 wt % or higher, 71 wt % or higher and even 86 wt % or higher. For some applications, excessive % Mn+% Ni+% Si seems to deteriorate the mechanical properties. In different embodiments, % Mn+% Ni+% Si is below 94 wt %, below 79 wt %, below 64 wt %, below 49 wt % and even below 34 wt %. For some applications, the presence of % Moeq is desirable, while in other applications it is rather an impurity. In different embodiments, % Moeq is 0.001 wt % or more, 0.12 wt % or more, 0.8 wt % or more, 1.58 wt % or more, 2.6 wt % or more, 3.26 wt % or more, 4.56 wt % or more and even 6.16 wt % or more. For some applications, excessive % Moeq seems to deteriorate the mechanical properties. In different embodiments, % Moeq is below 8.4 wt %, below 6.4 wt %, below 3.4 wt %, below 1.9 wt %, below 0.4 wt % and even below 0.09 wt %. Obviously, there are cases where the desired nominal content is Owt % or nominal absence as occurs with all optional elements for certain applications. For some applications, the presence of % Ceq is desirable, while in other applications it is rather an impurity. In different embodiments, % Ceq is above 0.02 wt %, above 0.26 wt %, above 0.56 wt %, above 1.26 wt % and even above 1.6 wt %. For some applications, excessive % Ceq seems to deteriorate the mechanical properties. In different embodiments, % Ceq is below 2.5 wt %, below 1.8 wt %, below 1.3 wt %, below 0.8 wt % and even below 0.3 wt %. Obviously, there are cases where the desired nominal content is Owt % or nominal absence as occurs with all optional elements for certain applications. For some applications, the presence of % C is desirable, while in other applications it is rather an impurity. In different embodiments, % C is above 0.01 wt %, above 0.21 wt %, above 0.51 wt %, above 1.21 wt % and even above 1.56 wt %. For some applications, excessive % C seems to deteriorate the mechanical properties. In different embodiments, % C is below 2.4 wt %, below 1.9 wt %, below 1.2 wt %, below 0.74 wt %, below 0.4 wt % and even below 0.29 wt %. Obviously, there are cases where the desired nominal content is Owt % or nominal absence of the element as occurs with all optional elements for certain applications. For some applications, the presence of % N is desirable, while in other applications it is rather an impurity. In different embodiments, % N is 0.009 wt % or more, 0.21 wt % or more, 0.41 wt % or more, 1.1 wt % or more and even 1.56 wt % or more. For some applications, excessive % N seems to deteriorate the mechanical properties. In different embodiments, % N is below 1.49 wt/o, below 0.89 wt %, below 0.39 wt %, below 0.14 wt % and even below 0.09 wt %. Obviously, there are cases where the desired nominal content is Owt % or nominal absence of the element as occurs with all optional elements for certain applications. For some applications, the presence % B is desirable, while in other applications it is rather an impurity. In different embodiments, % B is 0.0009 wt/o or more, 0.01 wt % or more, 0.31 wt % or more, 1.06 wt % or more and even 1.56 wt/o or more. For some applications, excessive % B seems to deteriorate the mechanical properties. In different embodiments, % B is below 1.9 wt %, below 0.79 wt %, below 0.29 wt %, below 0.1 wt % and even below 0.09 wt %. Obviously, there are cases where the desired nominal content is Owt % or nominal absence of the element as occurs with all optional elements for certain applications. For some applications, the presence of % O is desirable, while in other applications it is rather an impurity. In different embodiments, % O is 0.0006 wt % or more, 0.001 wt % or more, 0.12 wt % or more, 1.26 wt % or more and even 1.6 wt % or more. For some applications, higher % O contents are preferred. In different embodiments, % O is 2.1 wt % or more, 2.56 wt % or more, 3.12 wt % or more, 4.1 wt % or more and even 5.1 wt % or more. For some applications, excessive % O≤eems to deteriorate the mechanical properties. In different embodiments, % O is below 4.9 wt %, below 0.79 wt %, below 0.29 wt %, below 0.1 wt % and even below 0.09 wt %. For some applications, lower % O contents are preferred. In different embodiments, % O is below 149 ppm, below 99 ppm, below 49 ppm, below 29 ppm and even below 4 ppm. Obviously, there are cases where the desired nominal content is Owt % or nominal absence of the element as occurs with all optional elements for certain applications. For some applications, the presence of % Cr is desirable, while in other applications it is rather an impurity. In different embodiments, % Cr is 0.1 wt % or more, 0.51 wt % or more, 0.81 wt % or more, 1.21 wt % or more and even 1.56 wt % or more. For some applications, higher % Cr contents are preferred. In different embodiments, % Cr is 2.1 wt % or more, 2.51 wt % or more, 3.1 wt % or more, 4.1 wt % or more and even 6.1 wt % or more. For some applications, excessive % Cr seems to deteriorate the mechanical properties. In different embodiments, % Cr is below 7.9 wt %, below 5.9 wt %, below 4.4 wt %, below 3.1 wt % and even below 2.49 wt %. For some applications, lower % Cr contents are preferred. In different embodiments, % Cr is below 1.89 wt %, below 1.49 wt %, below 0.98 wt %, below 0.19 wt % and even below 0.1 wt %. Obviously, there are cases where the desired nominal content is Owt % or nominal absence of the element as occurs with all optional elements for certain applications. For some applications, the presence of % V is desirable, while in other applications it is rather an impurity. In different embodiments. % V is 0.0006 wt % or more, 0.01 wt % or more, 0.21 wt % or more, 0.81 wt % or more and even 1.06 wt % or more. For some applications, excessive % V seems to deteriorate the mechanical properties. In different embodiments, % V is below 3.9 wt %, below 2.9 wt %, below 1.4 wt %, below 0.89 wt % and even below 0.39 wt %. Obviously, there are cases where the desired nominal content is 0 wt % or nominal absence of the element as occurs with all optional elements for certain applications. In an embodiment, what has been said about AP1 for the powder size critical measure applies also to AP3. For some applications, the composition of the powder AP3 as defined in any of the embodiments above can be advantageously added to other powder mixtures disclosed throughout in this document, and particularly to each and any one of the mixtures LP and SP described throughout the present document. Accordingly, all the embodiments disclosed above can be combined among them and with any other embodiment disclosed in this document that relates to a powder AP3 in any combination, provided that they are not mutually exclusive.

In an embodiment, the mixture of SP and LP further comprises a powder AP4.

AP4 is a powder having the following composition, all percentages being indicated in weight percent: % V+% Mo_{eq}+% Mn+% Ni+% Si: 40-99.999; % Mo: 0-99.999; % W: 0-99.9; % C_{eq}: 0-2.99; % C: 0-2.99; % N: 0-2.2; % B: 0-2.9; % O: 0-8; % Cr: 0-9; % V: 0-99.99; % Mn+% Ni+% Si: 0-82; the rest consisting of iron and trace elements; wherein % Ceq-% C+0.86*% N+1.2*% B and % Moeq-% Mo+½*% W. In an embodiment, trace elements refers to several elements, unless context clearly indicates otherwise, including but not limited to H, He, Xe, F, S, P, Cu, Co, Pb, Ta, Zr, Nb, Hf, Cs, Y, Sc, Ne, Na, Cl, Ar, K, Br, Kr, Sr, Tc, Ru, Rh, Pd, Ag, I, Ba, Re, Os, Ir, Ti, Pt, Au, Hg, Tl, Po, At, Rn, Fr, Ra, Ac, Th, Pa, U, Np, Pu, Am, Cm, Bk, Cf, Es, Fm, Md, No, Lr, La, Ce, Pr, Nd, Pm, Sm. Eu, Gd, Tb, Dy, Ho, Er, Tm, Yb, Lu, Rf, Db, Sg, Bh, Hs, Li, Be, Mg, Ca, Rb, Zn, Cd, Al, Ga, In, Ge, Sn, Bi, Sb, As, Se, Te, Ds, Rg, Cn, Nh, Fl, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. In an embodiment, AP4 is not present. In an embodiment, the % of AP4 present is a function of % V+% Mo_{eq}+% Mn+% Ni+% Si present, that is to say the values given for % of AP4 refer to the value the % V+% Moeq+% Mn+% Ni+% Si of AP4 contributes and thus the real content of % AP4 is higher. In different embodiments, % Mo is 52 wt % or higher, 56 wt % or higher, 61 wt % or higher, 71 wt % or higher, 81 wt % or higher and even 91 wt % or higher. For some applications, excessive % Mo seems to deteriorate the mechanical properties. In different embodiments, % Mo is below 96 wt %, below 89 wt %, below 69 wt %, below 49 wt %, below 39 wt % and even below 24 wt %. For some applications, the presence of % W is desirable, while in other applications it is rather an impurity. In different embodiments, % W is above 0.01 wt %, above 10.1 wt %, above 31 wt %, above 51 wt % and even above 61 wt %. For some applications, excessive % W seems to deteriorate the mechanical properties. In different embodiments, % W is below 89 wt %, below 64 wt %, below 44 wt %, below 24 wt %, below 11.9 wt % and even below 7.9 wt %. Obviously, there are cases where the desired nominal content is Owt % or nominal absence of the element as occurs with all optional elements for certain applications. For some applications, higher % V+% Moeq+% Mn+% Ni+% Si contents are preferred. In different embodiments, % V+% Moeq+% Mn+% Ni+% Si is 51 wt % or higher, 57 wt % or higher, 62 wt % or higher, 71 wt % or higher, 82 wt % or higher and even 92 wt % or higher. For some applications, excessive % V+% Moeq+% Mn+% Ni+% Si seems to deteriorate the mechanical properties. In different embodiments, % V+% Moeq+% Mn+% Ni+% Si is below 96 wt %, below 89 wt %, below 74 wt %, below 70 wt %, below 64 wt % and even below 49 wt %. For some applications, higher % Mn+% Ni+% Si contents are preferred. In different embodiments, % Mn+% Ni+% Si is 11 wt % or higher, 32 wt % or higher, 41 wt % or higher, 53 wt % or higher and even 66 wt % or higher. For some applications, excessive % Mn+% Ni+% Si seems to deteriorate the mechanical properties. In different embodiments, % Mn+% Ni+% Si is below 68 wt %, below 59 wt %, below 44 wt %, below 39 wt %, below 24 wt % and even below 11.9 wt %. For some applications, the presence of % Ceq is desirable, while in other applications, it is rather an impurity. In different embodiments, % Ceq is above 0.009 wt %, above 0.27 wt %, above 0.6 wt %, above 1.2 wt % and even above 1.6 wt %. For some applications, excessive % Ceq seems to deteriorate the mechanical properties. In different embodiments, % Ceq is below 1.9 wt %, below 1.2 wt %, below 0.7 wt % and even below 0.4 wt %. Obviously, there are cases where the desired nominal content is 0 wt % or nominal absence as occurs with all optional elements for certain applications. For some applications, the presence of % C is desirable, while in other applications it is rather an impurity. In different embodiments, % C is above 0.01 wt %, above 0.21 wt %, above 0.51 wt %, above 1.21 wt % and even above 1.56 wt %. For some applications, excessive % C seems to deteriorate the mechanical properties. In different embodiments, % C is below 2.4 wt %, below 1.9 wt %, below 1.2 wt %, below 0.74 wt %, below 0.4 wt % and even below 0.29 wt %. Obviously, there are cases where the desired nominal content is Owt % or nominal absence of the element as occurs with all optional elements for certain applications. For some applications, the presence of %/N is desirable, while in other applications it is rather an impurity. In different embodiments, % N is 0.009 wt % or more, 0.21 wt % or more, 0.41 wt % or more, 1.1 wt % or more and even 1.56 wt % or more. For some applications, excessive % N seems to deteriorate the mechanical properties. In different embodiments, % N is below 1.49 wt %, below 0.89 wt %, below 0.39 wt %, below 0.14 wt % and even below 0.09 wt %. Obviously, there are cases where the desired nominal content is Owt % or nominal absence of the element as occurs with all optional elements for certain applications. For some applications, the presence of % B is desirable, while in other applications it is rather an impurity. In different embodiments, % B is 0.0009 wt % or more, 0.01 wt % or more, 0.31 wt % or more, 1.06 wt % or more and even 1.56 wt % or more. For some applications, excessive % B seems to deteriorate the mechanical properties. In different embodiments, % B is below 1.9 wt %, below 0.79 wt %, below 0.29 wt %, below 0.1 wt % and even below 0.09 wt %. Obviously, there are cases where the desired nominal content is Owt % or nominal absence of the element as occurs with all optional elements for certain applications. For some applications, the presence of % O is desirable, while in other applications it is rather an impurity. In different embodiments. % O is 0.0006 wt % or more, 0.001 wt % or more, 0.12 wt % or more, 1.26 wt % or more and even 1.6 wt % or more. For some applications, higher % O contents are preferred. In different embodiments, % O is 2.1 wt % or more, 2.56 wt % or more, 3.12 wt % or more, 4.1 wt % or more and even 5.1 wt % or more. For some applications, excessive % O≤eems to deteriorate the mechanical properties. In different embodiments, % O is below 4.9 wt %, below 0.79 wt %, below 0.29 wt %, below 0.1 wt % and even below 0.09 wt %. For some applications, lower % O contents are preferred. In different embodiments, % O is below 149 ppm, below 99 ppm, below 49 ppm, below 29 ppm and even below 4 ppm. Obviously, there are cases where the desired nominal content is Owt % or nominal absence of the element as occurs with all optional elements for certain applications. For some applications, the presence of % Cr is desirable, while in other applications it is rather an impurity. In different embodiments, % Cr is 0.1 wt % or more, 0.51 wt % or more, 0.81 wt % or more, 1.21 wt % or more and even 1.56 wt % or more. For some applications, higher % Cr contents are preferred. In different embodiments, % Cr is 2.1 wt % or more, 2.51 wt % or more, 3.1 wt % or more, 4.1 wt % or more and even 6.1 wt % or more. For some applications, excessive % Cr seems to deteriorate the mechanical properties. In different embodiments, % Cr is below 7.9 wt %, below 5.9 wt %, below 4.4 wt %, below 3.1 wt % and even below 2.49 wt %. For some applications, lower % Cr contents are preferred. In different embodiments, % Cr is below 1.89 wt %, below 1.49 wt %, below 0.98 wt %, below 0.19 wt % and even below 0.1 wt %. Obviously, there are cases where the desired nominal content is Owt % or nominal absence of the element as occurs with all optional elements for certain applications. For some applications, the presence of % V is desirable, while in other applications it is rather an impurity. In different embodiments, % V is 0.006 wt % or more, 0.12 wt % or more, 0.26 wt % or more, 0.91 wt % or more and even 1.26 wt % or more. For some applications, even higher % V contents are preferred. In different embodiments, % V is 2.6 wt % or more, 6.1 wt % or more, 12.6 wt % or more, 25.6% or more and even 51 wt % or more. For some applications, excessive % V seems to deteriorate the mechanical properties. In different embodiments, % V is below 89 wt %, below 74 wt %, below 54 wt %, below 44 wt % and even below 39 wt %. For some applications, even lower % V contents are preferred. In different embodiments, % V is below 24 wt %, below 14 wt %, below 8 wt %, below 4 wt % and even below 1.9 wt %. Obviously, there are cases where the desired nominal content is Owt % or nominal absence of the element as occurs with all optional elements for certain applications. In an embodiment, what has been said about AP1 for the powder size critical measure applies also to AP4. For some applications, the composition of the powder AP4 as defined in any of the embodiments above can be advantageously added to other powder mixtures disclosed throughout in this document, and particularly to each and any one of the mixtures LP and SP described throughout the present document. Accordingly, all the embodiments disclosed above can be combined among them and with any other embodiment disclosed in this document that relates to a powder AP4 in any combination, provided that they are not mutually exclusive.

A very interesting observation has been made for this type of powder mixture, especially when tailored to manufacture large components. This observation is also extensible to the other powder mixtures of this invention with limited hardenability, and in general when a component larger than the hardenability of the alloy system chosen allows is to be manufactured. Traditionally, to be able to manufacture large components, the alloy system chosen has to present good hardenability. The larger the component the more outstanding the hardenability of the alloying system chosen has to be. Unfortunately, most strategies leading to increased hardenability lead to diminished thermal conductivity, which as mentioned is one of the key performance parameters for the applications of interest of this powder mixture. The observation consists of seeing that an alloying system with rather low hardenability can be employed with formidable results (in terms of mechanical properties, including toughness and obviously thermal conductivity) as long as some strict guidelines are followed in the design of the component (smart usage of bainite).

For several applications, including most hot work toolings, it is interesting to have a steel with as high a thermal conductivity as possible and good mechanical properties especially in terms of toughness and sufficient yield strength both at room temperature and high temperatures. While the formulations provided for the powder mix might constitute an invention on their own. In some instances, also the final overall composition might also constitute a standalone invention. For such applications, the inventor has found that the following mixture (comprising at least LP and SP) is of interest:

LP is a powder having the following composition, all percentages being indicated in weight percent: % Mo: 0-8.9; % W: 0-3.9; % Moeq: 1.6-8.9; % Ceq: 0-1.49; % C: 0-1.49; % N: 0-0.2; % B: 0-0.8; % Si: 0-2.5; % Mn: 0-2.9; % Ni: 0-2.9; % Mn+2*% Ni: 0-6.8; % Cr: 0-2.9; % V: 0-3.9; % Nb: 0-2.9; % Zr: 0-3.9; % Hf: 0-2.9; % Ta: 0-2.9; % S: 0-0.8; % P: 0-0.8; % Pb: 0-1.9; % Cu: 0-3.9; % Bi: 0-0.8; % Se: 0-0.8; % Co: 0-3.9; % REE: 0-1.4; % Y: 0-0.96; % Sc: 0-0.96; % Cs: 0-1.4; % O: 0-0.299: the rest consisting of iron and trace elements, wherein % Ceq=% C+0.86*% N+1.2*% B and % Moeq=% Mo+½*% W: and wherein % REE is as previously defined. In an embodiment, trace elements refers to several elements, unless context clearly indicates otherwise, including but not limited to H, He, Xe, F. Ne, Na, Cl, Ar, K, Br, Kr, Sr, Tc, Ru, Rh, Pd, Ag, I. Ba, Re, Os, Ir, Ti, Pt, Au, Hg, Tl, Po, At, Rn, Fr, Ra, Rf, Db, Sg, Bh, Hs, Li, Be, Mg, Ca, Rb, Zn, Cd, Al, Ga, In, Ge, Sn, Sb, As, Te, Ds, Rg, Cn, Nh, Fl. Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the presence of % Y is desirable, while in other applications it is rather an impurity. In different embodiments, % Y is above 0.012 wt %, above 0.052 wt %, above 0.12 wt %, above 0.22 wt %, above 0.42 wt % and even above 0.82 wt %. For some applications, excessive % Y seems to deteriorate the mechanical properties. In different embodiments, % Y is below 0.74 wt %, below 0.48 wt %, below 0.34 wt %, below 0.18 wt % and even below 0.09 wt %. Obviously, there are cases where the desired nominal content is Owt % or nominal absence of the element as occurs with all optional elements for certain applications. For some applications, the presence of % Sc is desirable, while in other applications it is rather an impurity. In different embodiments, % Sc is above 0.012 wt %, above 0.052 wt %, above 0.12 wt %, above 0.22 wt %, above 0.42 wt % and even above 0.82 wt %. For some applications, excessive % Sc seems to deteriorate the mechanical properties. In different embodiments, % Sc is below 0.74 wt %, below 0.48 wt %, below 0.34 wt % and even below 0.18 wt %. Obviously, there are cases where the desired nominal content is Owt % or nominal absence of the element as occurs with all optional elements for certain applications. For some applications, a certain content of % Sc+% Y is desirable. In different embodiments, % Sc+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt %. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, excessive % REE seems to deteriorate the mechanical properties. In different embodiments, % REE is below 1.4 wt %, below 0.96 wt %, below 0.74 wt % and even below 0.48 wt %. Obviously, there are cases where the desired nominal content is Owt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments, % Sc+% Y+% REE is below 1.4 wt %, below 0.96, below 0.74 wt % and even below 0.48 wt %. In some embodiments, the above disclosed for the content of % O, % Cs, % Y, % Sc, % REE and/or % Ti can also be applied to the composition of LP. For some applications, the relation between the atomic content of % O and % Y+% Sc or alternatively % Y or alternatively % Y+% Sc+% REE has to be controlled for optimum mechanical properties according to the formulas previously disclosed. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, excessive % O≤eems to deteriorate the mechanical properties. In different embodiments, % O is below 2990 ppm, below 1900 ppm, below 900 ppm and even below 490 ppm. Obviously, there are cases where the desired nominal content is Owt % or nominal absence of the element as occurs with all optional elements for certain applications. For some applications, the presence of % C is desirable, while in other applications, it is rather an impurity. In different embodiments, % C is above 0.01 wt %, above 0.09 wt %, above 0.11 wt % and even above 0.16 wt %. As it is well known, % C content has a strong effect in reducing the temperature at which martensitic transformation starts. For some applications, higher % Ceq contents are desirable for either high wear resistance or where a fine bainite is desirable. In different embodiments, % C is above 0.21 wt %, above 0.26 wt %, above 0.31 wt % and even above 0.33 wt %. For some applications, particularly when increasing carbide formers content, also % C has to be increased in order to combine with those elements. In different embodiments, % C is above 0.34 wt %, above 0.36 wt % and even above 0.416 wt %. For applications requiring improved wear resistance higher % C contents are preferred. In different embodiments, % C is above 0.64 wt %, above 0.86 wt %, above 1.06 wt % and even above 1.16 wt %. For some applications, excessive % C seems to deteriorate the mechanical properties. In different embodiments, % C is below 1.2 wt %, below 0.94 wt %, below 0.79 wt % and even below 0.64 wt %. For some applications, lower % C contents are preferred. In different embodiments. % C is below 0.44 wt %, below 0.39 wt %, below 0.29 wt % and even below 0.24 wt %. For some applications, lower % C contents are preferred. In different embodiments, % C is below 0.19 wt %, below 0.12 wt %, below 0.09 wt % and even below 0.04 wt %. As previously disclosed, some applications benefit from a low interstitial content level in the generalized way already exposed, but some applications present even better results with somewhat different control over the level of interstitials. In different embodiments, % C is kept below 2890 ppm, below 890 ppm, below 490 ppm, below 196 ppm and even below 96 ppm. Obviously, there are cases where the desired nominal content is Owt % or nominal absence of the element as occurs with all optional elements for certain applications. For some applications, the presence of % Ceq is desirable, while in other applications, it is rather an impurity. In different embodiments, % Ceq is above 0.06 wt %, above 0.16 wt %, above 0.19 wt %, above 0.23 wt % and even above 0.26 wt %. The inventor has found that for some applications requiring good wear resistance in combination with high toughness within the present invention, higher % Ceq contents are preferred. In different embodiments, % Ceq is above 0.28 wt %, above 0.32 wt %, above 0.37 wt % and even above 0.42 wt %. For some applications, even higher % Ceq contents are preferred. In different embodiments, % Ceq is above 0.66 wt %, above 0.82 wt %, above 0.91 wt % and even above 1.16 wt %. On the other hand, for some applications, too high levels of % Ceq lead to impossibility to attain the required nature and perfection of carbides (nitrides, borides, oxides or combinations) regardless of the heat treatment applied. In different embodiments, % Ceq is less than 1.3%, less than 0.98 wt %, below 0.74 wt % and even below 0.57 wt %. For some applications, lower % Ceq contents are preferred. In different embodiments, % Ceq is less than 0.44 wt %, less than 0.34 wt %, below 0.24 wt % and even below 0.17 wt %. For some applications, even lower % Ceq contents are preferred. In different embodiments, % Ceq is below 0.14 wt %, below 0.1 wt %, below 0.08 wt % and even below 0.03 wt %. As previously disclosed, some applications benefit from a low interstitial content level in the generalized way already exposed, but some applications present even better results with somewhat different control over the level of interstitials. In different embodiments, % Ceq is below 890 ppm, below 490 ppm, below 90 ppm and even below 40 ppm. Obviously, there are cases where the desired nominal content is Owt % or nominal absence as occurs with all optional elements for certain applications. For some applications, the presence of % N is desirable, while in other applications it is rather an impurity. In different embodiments, % N is above 0.0001 wt %, above 0.001 wt %, above 0.009 wt %, above 0.09 wt % and even above 0.01 wt %. For some applications, higher % N contents are preferred. In different embodiments, % N is above 0.06 wt %, above 0.09 wt %, above 0.1 wt % and even above 0.13 wt %. For some applications, excessive % N seems to deteriorate the mechanical properties. In different embodiments, % N is below 0.18 wt %, below 0.14 wt %, below 0.09 wt %, below 0.01 wt % and even below 0.001 wt %. As previously disclosed, some applications benefit from a low interstitial content level in the generalized way already exposed, but some applications present even better results with somewhat different control over the level of interstitials. In different embodiments, % N is kept below 1900 ppm, below 900 ppm, below 490 ppm, below 190 ppm, below 90 ppm and even below 40 ppm. Obviously, there are cases where the desired nominal content is Owt % or nominal absence of the element as occurs with all optional elements for certain applications. For some applications, higher % Mo contents are preferred for high thermal conductivity. In different embodiments, % Mo is above 0.3 wt %, above 0.6 wt %, above 1.1 wt % and even above 1.4 wt %. For some applications, higher % Mo contents are preferred. In different embodiments. % Mo is above 1.6 wt %, above 1.8 wt %, above 2.1 wt % and even above 3.1 wt %. In some embodiments, even higher % Mo contents are preferred. In different embodiments, % Mo is above 4.2 wt %, above 4.7 wt %, above 6.1 wt % and even above 7.1 wt %. For some applications, an excessive content of % Mo may adversely affect the mechanical properties. In different embodiments, % Mo is below 7.9 wt %, below 6.4 wt %, below 5.7 wt %, below 4.3 wt %, below 3.9 wt % and even below 3.4 wt %. For some applications, an excessive content of molybdenum may adversely affect the mechanical properties. In different embodiments, % Mo is below 2.9 wt %, below 2.4 wt %, below 1.7 wt %, below 1.3 wt %, below 0.94 wt % and even below 0.49 wt %. Obviously, there are cases where the desired nominal content is Owt % or nominal absence of the element as occurs with all optional elements for certain applications. For some applications, % Mo can be partially replaced with % W. This replacement takes place in terms of % Moeq. In different embodiments, the replacement of % Mo with % W is lower than 74 wt %, lower than 59 wt %, lower than 39 wt % and even lower than 14 wt %. For applications where thermal conductivity is to be maximized but thermal fatigue has to be regulated, it is normally preferred to have from 1.2 to 3 times more % Mo than % W, but not absence of % W. For some applications, higher % Moeq contents are preferred for high thermal conductivity. In different embodiments. % Moeq is above 1.8 wt %, above 2.1 wt % and even above 2.6 wt %. For some applications, higher % Moeq contents are preferred. In different embodiments, % Moeq is above 3.1 wt %, above 3.7 wt %, above 4.8 wt %, above 5.1 wt % and even above 6.2 wt %. On the other hand, for some applications too high levels of % Moeq may adversely affect the thermal conductivity. In different embodiments. % Moeq is below 8.4 wt %, below 7.9 wt %, below 6.9 wt %, below 5.4 wt %, below 4.4 wt % and even below 3.9 wt %. For some applications lower % Moeq contents are preferred. In different embodiments. % Moeq is below 3.4 wt %, below 2.9 wt %, below 2.6 wt %, below 2.4 wt %, below 2.2 wt % and even below 1.9 wt %. For some applications, particularly when deformation control during the heat treatment is important, it is desirable that % W is not absent. In different embodiments, % W is above 0.26 wt %, above 0.86 wt %, above 1.16 wt %, above 1.66 wt % and even above 2.2 wt %. For some applications, excessive % W seems to deteriorate the mechanical properties. In different embodiments, % W is below 2.94 wt %, below 2.4 wt %, below 1.4 wt % and even below 0.9 wt %. For some applications, lower % W contents are preferred. In different embodiments, % W is below 0.8 wt %, below 0.74 wt %, below 0.39 wt % or even no intentional % W at all. Obviously, there are cases where the desired nominal content is Owt % or nominal absence of the element as occurs with all optional elements for certain applications. For some applications, the presence of % V is desirable, while in other applications it is rather an impurity. In different embodiments, % V is above 0.06 wt %, above 0.17 wt %, above 0.21 wt % and even above 0.26 wt %. For some applications, even higher % V contents are preferred. In different embodiments, % V is above 0.56 wt %, above 0.87 wt %, above 1.21 wt % and even above 1.56 wt %. For some applications, excessive % V seems to deteriorate the mechanical properties. In different embodiments, % V is below 2.9 wt %, below 2.3 wt %, below 1.8 wt %, below 1.3 wt % and even below 0.98 wt %. The inventor has found that for some applications, lower % V contents are preferred. In different embodiments, % V is below 0.89 wt %, below 0.49 wt %, below 0.19 wt % and even below 0.09 wt %. Obviously, there are cases where the desired nominal content is Owt % or nominal absence of the element as occurs with all optional elements for certain applications. It has been surprisingly found, that when the proper geometrical design strategy is employed great results can be achieved by having a controlled level of % B in the LP which is intentional. In different embodiments, % B is kept above 1 ppm, above 11 ppm, above 21 ppm, above 31 ppm and even above 51 ppm. For some applications, it has been found that the final properties of the component, can be surprisingly improved by the usage of rather high % B contents in LP. In different embodiments, % B is kept above 61 ppm, above 111 ppm, above 221 ppm, above 0.06 wt %, above 0.12 wt %, above 0.26 wt % and even above 0.6 wt %. Even in some of those applications, an excessive % B content ends up being detrimental. In different embodiments, % B is kept below 0.4 wt %, below 0.19 wt %, below 0.09 wt % and even below 0.04 wt %. For some applications, excessive % B seems to deteriorate the mechanical properties. In different embodiments, % B is kept below 400 ppm, below 190 ppm, below 90 ppm, below 40 ppm and even below 9 ppm. Obviously, there are cases where the desired nominal content is Owt % or nominal absence of the element as occurs with all optional elements for certain applications. For some applications, the presence of % Cr is desirable, while in other applications it is rather an impurity. In different embodiments, % Cr is above 0.09 wt %, above 0.16 wt %, above 0.56 wt %, above 0.86 wt %, above 1.1 wt %, above 1.6 wt % and even above 2.1 wt %. For some applications, if very high thermal conductivity is required, it is often desirable to avoid an excessive % Cr content. In different embodiments, % Cr is below 2.4 wt %, below 2.1 wt %, below 1.7 wt %, below 1.3 wt % and even below 0.8 wt %. For some applications, lower % Cr contents are preferred. In different embodiments, % Cr is below 0.7 wt %, below 0.44 wt %, below 0.19 wt % and even below 0.09 wt %. Obviously, there are cases where the desired nominal content is Owt % or nominal absence of the element as occurs with all optional elements for certain applications. For some applications, the presence of % Ni is desirable, while in other applications, it is rather an impurity. In different embodiments, % Ni is above 0.09 wt %, above 0.12 wt %, above 0.31 wt %, above 0.61 wt %, above 1.16 wt % and even above 1.7 wt %. For some applications, an excessive content of % Ni may adversely affect the mechanical properties. In different embodiments, % Ni is below 2.4 wt %, below 1.4 wt %, below 0.94 wt %, below 0.24 wt % and even below 0.1 wt %. Obviously, there are cases where the desired nominal content is Owt % or nominal absence of the element as occurs with all optional elements for certain applications. There are other elements that the inventor has found as strong or at least netto contributors to hardenability in the ferritic/perlitic domain which can be used in combination or as a replacement of % Ni, the most significant being % Cu and % Mn and to a lesser extent % Si. For some applications, the presence of % Si is desirable, while in other applications, it is rather an impurity. In different embodiments, % Si is above 0.06 wt %, above 0.1 wt %, above 0.26 wt %, above 0.51 wt % and even above 0.76 wt %. For some applications, higher % Si contents are preferred. In different embodiments, % Si is above 1.1 wt %, above 1.4 wt %, above 1.6 wt %, above 1.8 wt % and even above 2.1 wt %. For some applications, excessive % Si seems to deteriorate the mechanical properties. In different embodiments, % Si is below 2.2 wt %, below 1.9 wt %, below 1.4 wt %, below 1.2 wt % and even below 1 wt %. For some applications, lower % Si contents are preferred. In different embodiments, % Si is below 0.84 wt %, below 0.64 wt %, below 0.49 wt %, below 0.24 wt % and even below 0.09 wt %. Obviously, there are cases where the desired nominal content is Owt % or nominal absence of the element as occurs with all optional elements for certain applications. For some applications, the presence of % Mn is desirable, while in other applications it is rather an impurity. In different embodiments, % Mn is above 0.1 wt %, above 0.26 wt %, above 0.56 wt %, above 0.86 wt % and even above 1.1 wt %. For some applications, higher % Mn contents are preferred. In different embodiments. % Mn is above 1.4 wt %, above 1.7 wt %, above 1.9 wt % and even above 2.1 wt %. For some applications, excessive % Mn seems to deteriorate the mechanical properties. In different embodiments. % Mn is below 2.4 wt %, below 1.7 wt %, below 1.2 wt %, below 0.94 wt % and even below 0.79 wt %. For some applications, lower % Mn contents are preferred. In different embodiments, % Mn is below 0.6 wt %, below 0.4 wt %, below 0.24 wt %, below 0.1 wt % and even below 0.04 wt %. Obviously, there are cases where the desired nominal content is Owt % or nominal absence of the element as occurs with all optional elements for certain applications. For some applications, the presence of % Co is desirable, while in other applications it is rather an impurity. In different embodiments, % Co is above 0.06 wt %, above 0.12 wt %, above 0.26 wt %, above 0.51 wt % and even above 1.1 wt %. For some applications, excessive % Co seems to deteriorate the mechanical properties. In different embodiments, % Co is below 2.8 wt %, below 1.4 wt %, below 0.6 wt %, below 0.4 wt %, below 0.19 wt % and even below 0.02 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0006 wt %, above 0.09 wt %, above 0.12 wt %, above 0.16 wt % and even above 0.52 wt %. For some applications, even higher % Pb contents are preferred. In different embodiments, % Pb is above 0.76 wt %, above 0.9 wt %, above 1.2 wt % and even above 1.4 wt %. For some applications, excessive % Pb seems to deteriorate the mechanical properties. In different embodiments, % Pb is below 1.4 wt %, below 0.9 wt %, below 0.44 wt %, below 0.24 wt %, below 0.09 wt % and even below 0.02 wt %. Obviously, there are cases where the desired nominal content is Owt % or nominal absence of the element as occurs with all optional elements for certain applications. For some applications, the presence of % Bi is desirable, while in other applications it is rather an impurity. In different embodiments, % Bi is above 0.0002 wt %, above 0.06 wt %, above 0.1 wt %, above 0.14 wt % and even above 0.51 wt %. For some applications, excessive % Bi seems to deteriorate the mechanical properties. In different embodiments, % Bi is below 0.64 wt %, below 0.4 wt %, below 0.24 wt %, below 0.14 wt %, below 0.09 wt % and even below 0.01 wt %. Obviously, there are cases where the desired nominal content is Owt % or nominal absence of the element as occurs with all optional elements for certain applications. For some applications, the presence of % Se is desirable, while in other applications it is rather an impurity. In different embodiments, % Se is above 0.0006 wt %, above 0.05 wt %, above 0.12 wt %, above 0.16 wt % and even above 0.51 wt %. For some applications, excessive % Se seems to deteriorate the mechanical properties. In different embodiments, % Se is below 0.44 wt %, below 0.2 wt %, below 0.13 wt %, below 0.09 wt % and even below 0.009 wt %. Obviously, there are cases where the desired nominal content is Owt % or nominal absence of the element as occurs with all optional elements for certain applications. For some applications, the presence of % Hf is advantageous. In different embodiments, % Hf is above 0.08 wt %, above 0.25 wt %, above 0.51 wt %, above 0.76 wt %, above 1.1 wt % and even above 1.6 wt %. The inventor has found that for applications requiring high toughness levels, the % Hf and/or % Zr content should not be very high, as they tend to form big and polygonal primary carbides which act as stress raisers. In different embodiments, % Hf is below 1.9 wt %, below 1.4 wt %, below 0.98 wt % and even below 0.49 wt %. For some applications, lower % Hf contents are preferred. In different embodiments, % Hf is below 0.4 wt %, below 0.24 wt %, below 0.12 wt %, below 0.08 wt % and even below 0.002 wt %. For some applications, where the presence of strong carbide formers is advantageous, but where manufacturing cost is of importance the presence of % Zr is desirable. In different embodiments, % Zr is above 0.06 wt %, above 0.1 wt %, above 0.16 wt % and even above 0.52 wt %. For some applications, excessive % Zr seems to deteriorate the mechanical properties. In different embodiments, % Zr is below 2.8 wt %, below 1.9 wt %, below 1.5 wt % and even below 0.94 wt %. For some applications, lower % Zr contents are preferred. In different embodiments, % Zr is below 0.44 wt %, below 0.12 wt %, below 0.04 wt % and even below 0.002 wt %. For some applications, % Zr and/or % Hf can be partially or totally replaced by % Ta. In different embodiments, more than 26 wt % of the amount of % Hf and/or % Zr are replaced by % Ta, more than 56 wt % of the amount of % Hf and/or % Zr are replaced by*% Ta and even more than 76 wt % of the amount of % Hf and/or % Zr are replaced by % Ta. In different embodiments, % Ta+% Zr is above 0.0009 wt %, above 0.009 wt %, above 0.01 wt % above 0.09 wt % and even above 0.11 wt %. For some applications, excessive % Ta+% Zr seems to deteriorate the mechanical properties. In different embodiments, % Ta+% Zr is below 2.4 wt %, below 0.94 wt %, below 0.44 wt % below 0.24 wt % and even below 0.09 wt %. For some applications, when it comes to wear resistance the presence of % Hf and/or % Zr has a positive effect. If this is to be greatly increased, then other strong carbide formers like % Ta or even % Nb can also be used. In different embodiments. % Zr+% Hf+% Nb+% Ta is above 0.1 wt %, above 0.56 wt %, above 0.76 wt % and even above 1.1 wt %. For some applications, excessive % Zr+% Hf+% Nb+% Ta seems to deteriorate the mechanical properties. In different embodiments, % Zr+% Hf+% Nb+% Ta is below 1.9 wt %, below 0.94 wt %, below 0.4 wt % below 0.14 wt % and even below 0.08 wt %. For some applications, the presence of % P is desirable, while in other applications, it is rather an impurity. In different embodiments, % P is above 0.0001 wt %, above 0.001 wt %, above 0.009 wt % and even above 0.01 wt %. For some applications, % P and/or % S should be kept as low as possible for high thermal conductivity. In different embodiments, % P is below 0.6 wt %, below 0.48 wt %, below 0.4 wt %, below 0.24 wt % and even below 0.2 wt %. For some applications, lower % P contents are preferred. In different embodiments. % P is below 0.1 wt %, below 0.08 wt %, below 0.04 wt %, below 0.009 wt % and even below 0.004 wt %. For some applications, even lower % P contents are preferred. In different embodiments, % P is below 0.0009 wt %, below 0.0007 wt % and even below 0.0004 wt %. Obviously, there are cases where the desired nominal content is 0 wt % or nominal absence of the element as occurs with all optional elements for certain applications. For some applications, the presence of % S is desirable, while in other applications, it is rather an impurity. In different embodiments, % S is above 0.006 wt %, above 0.02 wt %, above 0.1 wt %, above 0.15 wt % and even above 0.36 wt %. For some applications, excessive % S seems to deteriorate the mechanical properties. In different embodiments, % S is below 0.64 wt %, below 0.39 wt %, below 0.14 wt %, below 0.09 wt %, below 0.04 wt % and even below 0.009 wt %. For some applications, lower % S contents are preferred. In different embodiments, % S is below 0.0008 wt %, below 0.0006 wt %, below 0.0004 wt % and even below 0.0001 wt %. Obviously, there are cases where the desired nominal content is Owt % or nominal absence of the element as occurs with all optional elements for certain applications. For some applications, a certain content of % Mn+2*% Ni is desirable. In different embodiments, % Mn+2*% Ni is 0.06 wt % or more, 0.12 wt % or more, 0.21 wt % or more, 0.56 wt % or more, 0.76 wt % or more, 1.2 wt % or more, 1.56 wt % or more and even 2.16 wt % or more. For some applications, even higher contents of % Mn+2*% Ni are preferred. In different embodiments, % Mn+2*% Ni is 2.6 wt % or more, 3.1 wt % or more, 3.6 wt % or more and even 4.1 wt % or more. For some applications, excessive % Mn+2*% Ni seems to deteriorate the mechanical properties. In different embodiments, % Mn+2*% Ni is 3.4 wt % or less, 2.9 wt % or less, 1.4 wt % or less, 1.2 wt % or less, 0.89 wt % or less, 0.74 wt % or less and even 0.48 wt % or less. Surprisingly enough, the controlled presence of % B seems to have a strong influence for some applications on the desirable level of % Mn+2*% Ni, some applications strongly benefiting from such presence and some on the contrary suffering from it. In different embodiments, when % B present in a quantity above 12 ppm, % Mn+2*% Ni is kept above 0.01 wt % above 0.06 wt %, above 0.16 wt %, above 0.26 wt %, above 0.46 wt %, above 0.86 wt % and even above 1.56 wt %. As said, some applications (including some applications involving heat transference) do not benefit from the concurrent presence of high levels of % Mn+2*% Ni and % B. In different embodiments, when % B present in a quantity above 12 ppm, % Mn+2*% Ni is kept below 1.96 wt %, below 0.96 wt %, below 0.46 wt %, below 0.24 wt % and even below 0.09 wt %. For some applications, a certain content of % Cu+% Ni is desirable. In different embodiments, % Cu+% Ni is above 0.26 wt %, above 0.56 wt %, above 0.76 wt % and even above 1.1 wt %. For some applications, excessive % Cu+% Ni seems to deteriorate the mechanical properties. In different embodiments, % Cu+% Ni is below 3.9 wt %, below 2.4 wt %, below 1.4 wt % and even below 0.9 wt %. All the upper and lower limits disclosed in the different embodiments can be combined among them in any combination, provided that they are not mutually exclusive, for example % Mn+2*% Ni=0.06-3.4 wt % or % Mn+2*% Ni=0.21-1.2 wt %. Most applications benefit from the general size ranges for the larger powder stated above, but some applications benefit from a somewhat different size distribution. In different embodiments, the “powder size critical measure” (as previously defined) for LP is 2 microns or larger, 22 microns or larger, 42 microns or larger, 52 microns or larger, 102 microns or larger and even 152 microns or larger. For some applications, excessively large size critical measures are difficult to deal especially for some fine detail geometries. In different embodiments, the “powder size critical measure” (as previously defined) for LP is 1990 microns or smaller, 1490 microns or smaller, 990 microns or smaller, 490 microns or smaller, 290 microns or smaller, 190 microns or smaller and even 90 microns or smaller. For some applications it has been found that the manufacturing method for the larger powder has a remarkable influence in the attainable properties of the final component. In an embodiment, LP is a non-spherical powder (as previously defined). In an embodiment, the LP is water atomized. In an embodiment, the LP comprises water atomized powder. In an embodiment, LP is a spherical powder (as previously defined). In an embodiment, the LP is centrifugal atomized. In an embodiment, the LP comprises centrifugal atomized powder. In an embodiment, the LP is mechanically crushed. In an embodiment, the LP comprises crushed powder. In an embodiment, the LP is reduced. In an embodiment, the LP comprises reduced powder. In an embodiment, the LP is gas atomized. In an embodiment, the LP comprises gas atomized powder.

SP is a powder having the following composition, all percentages being indicated in weight percent: % Mo: 0-2.9; % W: 0-2.9; % Moeq: 0-2.9; % Ceq: 0-2.99; % C: 0-2.99; % N: 0-0.2; % B: 0-0.8; % Si: 0-0.9; % Mn: 0-1.9; % Ni: 0-2.9; % Mn+2*% Ni: 0-6.8; % Cr: 0-1.9; % V: 0-0.9; % Nb: 0-0.9; % Zr: 0-0.4; % Hf: 0-0.4; % Ta: 0-0.4: % S: 0-0.2;% P: 0-0.09; % Pb: 0-0.9; % Cu: 0-1.9; % Bi: 0-0.2;% Se: 0-0.2; % Co: 0-1.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq=% Mo+½*% W: and wherein % REE is as previously defined. In an embodiment, trace elements refers to several elements, unless context clearly indicates otherwise, including but not limited to H, He, Xe, F. Ne, Na, Cl, Ar, K, Br, Kr, Sr, Tc, Ru, Rh, Pd, Ag, I, Ba, Re, Os, Ir, Ti, Pt, Au, Hg, Tl, Po, At, Rn, Fr, Ra, Rf, Db, Sg, Bh, Hs, Li, Be, Mg, Ca, Rb, Zn, Cd, Al, Ga, In, Ge, Sn, Sb, As, Te, Ds, Rg, Cn, Nh, Fl. Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the presence of % Y is desirable, while in other applications it is rather an impurity. In different embodiments, % Y is above 0.012 wt %, above 0.052 wt %, above 0.12 wt %, above 0.22 wt %, above 0.42 wt % and even above 0.82 wt %. For some applications, excessive % Y seems to deteriorate the mechanical properties. In different embodiments, % Y is below 0.74 wt %, below 0.48 wt %, below 0.34 wt %, below 0.18 wt % and even below 0.09 wt %. Obviously, there are cases where the desired nominal content is Owt % or nominal absence of the element as occurs with all optional elements for certain applications. For some applications, the presence of % Sc is desirable, while in other applications it is rather an impurity. In different embodiments, % Sc is above 0.012 wt %, above 0.052 wt %, above 0.12 wt %, above 0.22 wt %, above 0.42 wt % and even above 0.82 wt %. For some applications, excessive % Sc seems to deteriorate the mechanical properties. In different embodiments, % Sc is below 0.74 wt %, below 0.48 wt %, below 0.34 wt % and even below 0.18 wt %. Obviously, there are cases where the desired nominal content is Owt % or nominal absence of the element as occurs with all optional elements for certain applications. For some applications, a certain content of % Sc+% Y is desirable. In different embodiments, % Sc+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt %. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, excessive % REE seems to deteriorate the mechanical properties. In different embodiments, % REE is below 1.4 wt %, below 0.96 wt %, below 0.74 wt % and even below 0.48 wt %. Obviously, there are cases where the desired nominal content is Owt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments, % Sc+% Y+% REE is below 1.4 wt %, below 0.96, below 0.74 wt % and even below 0.48 wt %. In some embodiments, the above disclosed for the content of % O, % Cs, % Y, % Sc, % REE and/or % Ti can also be applied to the composition of SP. For some applications, the relation between the atomic content of % O and % Y+% Sc or alternatively % Y or alternatively % Y+% Sc+% REE has to be controlled for optimum mechanical properties according to the formulas previously disclosed. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, excessive % O≤eems to deteriorate the mechanical properties. In different embodiments, % O is below 2990 ppm, below 1900 ppm, below 900 ppm and even below 490 ppm. Obviously, there are cases where the desired nominal content is Owt % or nominal absence of the element as occurs with all optional elements for certain applications. For some applications, the presence of % C is desirable, while in other applications, it is rather an impurity. In different embodiments, % C is above 0.001 wt %, above 0.002 wt %, above 0.02 wt %, above 0.07 wt %, above 0.1 wt % and even above 0.12 wt %. For some applications, particularly when increasing carbide formers content, also % C has to be increased in order to combine with those elements. In different embodiments, % C is above 0.14 wt %, above 0.16 wt %, above 0.21 wt % and even above 0.28 wt %. For applications requiring improved wear resistance higher % C contents are preferred. In different embodiments, % C is above 0.56 wt %, above 0.76 wt %, above 1.16 wt %, above 1.56 wt % and even above 2.26 wt %. For some applications, an excessive content of % C may adversely affect the mechanical properties. In different embodiments, % C is below 2.4 wt %, below 1.98 wt %, below 1.48 wt %, below 0.98 wt and even below 0.69 wt %. For some applications, lower % C contents are preferred. In different embodiments, % C is below 0.49 wt %, below 0.32 wt %, below 0.28 wt %, below 0.23 wt %, below 0.14 wt and even below 0.09 wt %. Obviously, there are cases where the desired nominal content is Owt % or nominal absence of the element as occurs with all optional elements for certain applications. For some applications, the presence of % Ceq is desirable, while in other applications, it is rather an impurity. In different embodiments, % Ceq is above 0.001 wt %, above 0.06 wt %, above 0.1 wt %, above 0.21 wt % above 0.23 wt % and even above 0.31 wt %. The inventor has found that for some applications requiring good wear resistance in combination with high toughness within the present invention, higher % Ceq contents are preferred. In different embodiments, % Ceq is above 0.81 wt %, above 1.2 wt %, above 1.6 wt %, above 1.9 wt % and even above 2.1 wt %. On the other hand, for some applications, too high levels of % Ceq lead to impossibility to attain the required nature and perfection of carbides (nitrides, borides, oxides or combinations) regardless of the heat treatment applied. In different embodiments. % Ceq is below 2.3 wt %, below 1.9 wt %, below 1.4 wt %, below 0.9 wt and even below 0.64 wt %. For some applications, lower % Ceq contents are preferred. In different embodiments, % Ceq is less than 0.43 wt %, less than 0.34 wt %, less than 0.29 wt %, below 0.24 wt %, below 0.13 wt and even below 0.09 wt %. Obviously, there are cases where the desired nominal content is Owt % or nominal absence as occurs with all optional elements for certain applications. For some applications, the presence of % N is desirable, while in other applications it is rather an impurity. In different embodiments, % N is above 0.0002 wt %, above 0.0009 wt %, above 0.002 wt %, above 0.008 wt %, above 0.08 wt % and even above 0.02 wt %. For some applications, higher % N contents are preferred. In different embodiments, % N is above 0.07 wt %, above 0.096 wt %, above 0.11 wt % and even above 0.12 wt %. For some applications, excessive % N seems to deteriorate the mechanical properties. In different embodiments, % N is below 0.19 wt %, below 0.15 wt %, below 0.08 wt %, below 0.02 wt % and even below 0.002 wt %. Obviously, there are cases where the desired nominal content is Owt % or nominal absence of the element as occurs with all optional elements for certain applications. For some applications, higher % Mo contents are preferred for high thermal conductivity. In different embodiments, % Mo is above 0.003 wt %, above 0.1 wt %, above 0.16 wt %, above 0.26 wt % and even above 0.31 wt %. For some applications, higher % Mo contents are preferred. In different embodiments. % Mo is above 0.36 wt %, above 0.41 wt %, above 0.48 wt, above 0.86 wt % and even above 1.56 wt %. For some applications, excessive % Mo seems to deteriorate the mechanical properties. In different embodiments, % Mo is below 1.4 wt %, below 0.74 wt %, below 0.59 wt %, below 0.49 wt %, below 0.29 wt %, below 0.24 wt % and even below 0.1 wt %. Obviously, there are cases where the desired nominal content is Owt % or nominal absence of the element as occurs with all optional elements for certain applications. For some applications, % Mo can be partially replaced with % W. This replacement takes place in terms of % Moeq. In different embodiments, the replacement of % Mo with % W is lower than 69 wt %, lower than 54 wt %, lower than 34 wt % and even lower than 12 wt %. For applications where thermal conductivity is to be maximized but thermal fatigue has to be regulated, it is normally preferred to have from 1.2 to 3 times more % Mo than % W, but not absence of % W. For some applications, the presence of % Moeq is desirable, while in other applications it is rather an impurity. In different embodiments, % Moeq is above 0.002 wt %, above 0.06 wt %, above 0.16 wt % and even above 0.3 wt %. For some applications, higher % Moeq contents are preferred for high thermal conductivity. In different embodiments, % Moeq is above 0.46 wt %, above 0.6 wt %, above 1.3 wt % and even above 1.9 wt %. For some applications, the inventor has found that the total amount of % Moeq should be controlled and made sure it is not excessive. In different embodiments, % Moeq is below 2.4 wt %, below 1.9 wt %, below 1.5 wt % and even below 1.2 wt % k. On the other hand, too high levels of % Moeq will lead to situations where thermal conductivity can be negatively affected. In different embodiments, % Moeq is below 0.84 wt %, below 0.74 wt %, below 0.59 wt %, below 0.4 wt % and even below 0.29 wt %. Some applications benefit from a lower content of % Moeq. In different embodiments, % Moeq is below 0.24 wt %, below 0.1 wt % and even below 0.09 wt %. Obviously, there are cases where the desired nominal content is Owt % or nominal absence as occurs with all optional elements for certain applications. For some applications, particularly when deformation control during the heat treatment is important, it is desirable that % W is not absent. In different embodiments, % W is above 0.006 wt %, above 0.03 wt %, above 0.1 wt %, above 0.26 wt % and even above 0.36 wt %. For some applications, higher % W contents are preferred. In different embodiments, % W is above 0.4 wt %, above 0.66 wt %, above 1.1 wt % and even above 1.8 wt %. On the other hand, for some applications, excessive % W seems to deteriorate the mechanical properties. In different embodiments, % W is below 1.4 wt %, below 0.84 wt %, below 0.64 wt % and even below 0.49 wt %. Some applications benefit from a lower content of % W. In different embodiments, % W is below 0.38 wt %, below 0.24 wt %, below 0.09 wt % or even no intentional % W at all. Obviously, there are cases where the desired nominal content is Owt % or nominal absence of the element as occurs with all optional elements for certain applications. For some applications, the presence of % V is desirable, while in other applications, it is rather an impurity. In different embodiments, % V is above 0.006 wt %, above 0.04 wt %, above 0.09 wt %, above 0.16 wt % and even above 0.26 wt %. For some applications, an excessive content of % V may adversely affect the mechanical properties. In different embodiments, % V is below 0.8 wt %, below 0.6 wt %, below 0.4 wt % and even below 0.3 wt %. For some applications, lower % V contents are preferred. In different embodiments, % V is below 0.24 wt %, below 0.14 wt %, below 0.09 wt % and even below 0.009 wt %. Obviously, there are cases where the desired nominal content is Owt % or nominal absence of the element as occurs with all optional elements for certain applications. The inventor has surprisingly found that for some applications, small amounts of % B have a positive effect on increasing thermal conductivity. In different embodiments, % B is above 2 ppm, above 16 ppm, above 61 ppm and even above 86 ppm. The inventor has found that for some applications, in order to have a noticeable effect on the attainable bainitic microstructure, % B has to be present in somewhat higher contents that what is required for the increase of the hardenability in the ferrite/perlite domain. In different embodiments, % B is above 90 ppm, above 126 ppm, above 206 ppm and even above 326 ppm. For some applications, higher % B contents are preferred. In different embodiments, % B is above 0.09 wt %, above 0.11 wt %, above 0.26 wt % and even above 0.4 wt %. On the other hand, the effect on the toughness can be quite detrimental if excessive borides are formed. In different embodiments, % B is below 0.74 wt %, below 0.6 wt %, below 0.4 wt %, below 0.24 wt % and even below 0.12 wt %. For some applications, lower % B contents are preferred. In different embodiments, % B is below 740 ppm, below 490 ppm, below 140 ppm, below 80 ppm and even below 40 ppm. Obviously, there are cases where the desired nominal content is Owt % or nominal absence of the element as occurs with all optional elements for certain applications. For some applications, the presence of % Cr is desirable, while in other applications it is rather an impurity. In different embodiments. % Cr is above 0.001 wt %, above 0.1 wt %, above 0.56 wt %, above 0.86 wt %, above 1.1 wt % and even above 1.6 wt %. For some applications, if very high thermal conductivity is required, it is often desirable to avoid an excessive % Cr content. In different embodiments, % Cr is below 1.8 wt %, below 1.6 wt %, below 1.4 wt % and even below 0.9 wt %. For some applications, lower % Cr contents are preferred. In different embodiments, % Cr is below 0.6 wt %, below 0.4 wt %, below 0.14 wt % and even below 0.08 wt %. Obviously, there are cases where the desired nominal content is Owt % or nominal absence of the element as occurs with all optional elements for certain applications. For some applications, the presence of % Ni is desirable, while in other applications, it is rather an impurity. In different embodiments, % Ni is above 0.001 wt %, above 0.1 wt %, above 0.26 wt %, above 0.51 wt %, above 1.1 wt % and even above 1.6 wt %. For some applications, an excessive content of % Ni may adversely affect the mechanical properties. In different embodiments, % Ni is below 2.4 wt %, below 1.9 wt %, below 1.2 wt %, below 0.94 wt %, below 0.44 wt % and even below 0.19 wt %. For some applications, lower % Ni contents are preferred. In different embodiments, % Ni is below 0.14 wt %, below 0.09 wt %, below 0.009 wt %, below 0.003 wt % and even below 0.001 wt %. Obviously, there are cases where the desired nominal content is Owt % or nominal absence of the element as occurs with all optional elements for certain applications. There are other elements that the inventor has found as strong or at least netto contributors to hardenability in the ferritic/perlitic domain which can be used in combination or as a replacement of % Ni. The most significant being % Cu and % Mn and to a lesser extent % Si. The most significant being % Cu and % Mn and to a lesser extent % Si. For some applications, the presence of % Si is desirable, while in other applications, it is rather an impurity. In different embodiments, % Si is above 0.0009 wt %, above 0.09 wt %, above 0.16 wt %, above 0.31 wt %, above 0.56 wt % and even above 0.71 wt %. For some applications, excessive % Si seems to deteriorate the mechanical properties. In different embodiments, % Si is below 0.6 wt %, below 0.44 wt %, below 0.2 wt %, below 0.09 wt % and even below 0.004 wt %. Obviously, there are cases where the desired nominal content is Owt % or nominal absence of the element as occurs with all optional elements for certain applications. For some applications, the presence of % Mn is desirable, while in other applications it is rather an impurity. In different embodiments, % Mn is above 0.001 wt %, above 0.02 wt %, above 0.16 wt %, above 0.36 wt %, above 0.56 wt % and even above 1.2 wt %. For some applications, excessive % Mn seems to deteriorate the mechanical properties. In different embodiments, % Mn is below 1.6 wt %, below 1.4 wt %, below 1.1 wt %, below 0.9 wt % and even below 0.7 wt %. For some applications, lower % Mn contents are preferred. In different embodiments, % Mn is below 0.5 wt %, below 0.3 wt %, below 0.14 wt %, below 0.09 wt % and even below 0.04 wt %. Obviously, there are cases where the desired nominal content is Owt % or nominal absence of the element as occurs with all optional elements for certain applications. For some applications, the presence of % Co is desirable, while in other applications it is rather an impurity. In different embodiments, % Co is above 0.001 wt %, above 0.05 wt %, above 0.12 wt %, above 0.21 wt %, above 0.56 wt % and even above 1 wt %. For some applications, excessive % Co seems to deteriorate the mechanical properties. In different embodiments, % Co is below 1.2 wt %, below 0.4 wt %, below 0.2 wt %, below 0.09 wt % and even below 0.01 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0002 wt %, above 0.06 wt %, above 0.09 wt %, above 0.1 wt % and even above 0.56 wt %. For some applications, excessive % Pb seems to deteriorate the mechanical properties. In different embodiments, % Pb is below 0.6 wt %, below 0.4 wt %, below 0.1 wt %, below 0.09 wt %, below 0.04 wt % and even below 0.004 wt %. Obviously, there are cases where the desired nominal content is Owt % or nominal absence of the element as occurs with all optional elements for certain applications. For some applications, the presence of % Bi is desirable, while in other applications it is rather an impurity. In different embodiments, % Bi is above 0.0009 wt %, above 0.02 wt %, above 0.09 wt % and even above 0.11 wt %. For some applications, excessive % Bi seems to deteriorate the mechanical properties. In different embodiments, % Bi is below 0.14 wt %, below 0.1 wt %, below 0.09 wt %, below 0.009 wt % and even below 0.001 wt %. Obviously, there are cases where the desired nominal content is Owt % or nominal absence of the element as occurs with all optional elements for certain applications. For some applications, the presence of % Se is desirable, while in other applications it is rather an impurity. In different embodiments, % Se is above 0.0001 wt %, above 0.005 wt %, above 0.02 wt %, above 0.08 wt % and even above 0.1 wt %. For some applications, excessive % Se seems to deteriorate the mechanical properties. In different embodiments, % Se is below 0.12 wt %, below 0.07 wt %, below 0.009 wt % and even below 0.0009 wt %. Obviously, there are cases where the desired nominal content is Owt % or nominal absence of the element as occurs with all optional elements for certain applications. For some applications, the presence of % Hf is advantageous. In different embodiments, % Hf is above 0.001 wt %, above 0.008 wt %, above 0.05 wt %, above 0.09 wt % and even above 0.11 wt %. The inventor has found that for applications requiring high toughness levels, the % Hf and/or % Zr content should not be very high, as they tend to form big and polygonal primary carbides which act as stress raisers. In different embodiments, % Hf is below 0.29 wt %, below 0.19 wt %, below 0.14 wt %, below 0.09 wt % and even below 0.04 wt %. For some applications, where the presence of strong carbide formers is advantageous, but where manufacturing cost is of importance the presence of % Zr is desirable. In different embodiments, % Zr is above 0.0009 wt %, above 0.006 wt %, above 0.06 wt %, above 0.1 wt % and even above 0.12 wt %. For some applications, excessive % Zr seems to deteriorate the mechanical properties. In different embodiments, % Zr is below 0.28 wt %, below 0.18 wt %, below 0.13 wt %, below 0.08 wt % and even below 0.03 wt %. For some applications, % Zr and/or % Hf can be partially or totally replaced by % Ta. In different embodiments, more than 25 wt % of the amount of % Hf and/or % Zr are replaced by % Ta, more than 50 wt % of the amount of % Hf and/or % Zr are replaced by % Ta and even more than 75 wt % of the amount of % Hf and/or % Zr are replaced by % Ta. In different embodiments, % Ta+% Zr is above 0.0009 wt %, above 0.009 wt %, above 0.01 wt % above 0.09 wt % and even above 0.11 wt %. For some applications, excessive % Ta+% Zr seems to deteriorate the mechanical properties. In different embodiments, % Ta+% Zr is below 0.4 wt %, below 0.18 wt %, below 0.06 wt % and even below 0.0008 wt %. For some applications, when it comes to wear resistance the presence of % Hf and/or % Zr has a positive effect. If this is to be greatly increased, then other strong carbide formers like % Ta or even % Nb can also be used. In different embodiments, % Zr+% Hf+% Nb+% Ta is above 0.001 wt %, above 0.1 wt %, above 0.36 wt %, above 0.46 wt % and even above 0.76 wt %. For some applications, excessive % Zr+% Hf+% Nb+% Ta seems to deteriorate the mechanical properties. In different embodiments, % Zr+% Hf+% Nb+% Ta is below 0.9 wt %, below 0.46 wt %, below 0.34 wt %, below 0.16 wt % and even below 0.09 wt %. For some applications, the presence of % P is desirable, while in other applications, it is rather an impurity. In different embodiments, % P is above 0.0008 wt %, above 0.008 wt %, above 0.01 wt % and even above 0.03 wt %. For some applications, % P and/or % S should be kept as low as possible for high thermal conductivity. In different embodiments, % P is below 0.08 wt %, below 0.04 wt %, below 0.02 wt % and even below 0.002 wt %. Obviously, there are cases where the desired nominal content is Owt % or nominal absence of the element as occurs with all optional elements for certain applications. For some applications, the presence of % S is desirable, while in other applications, it is rather an impurity. In different embodiments, % S is above 0.006 wt %, above 0.016 wt %, above 0.12 wt % and even above 0.18 wt %. For some applications, excessive % S seems to deteriorate the mechanical properties. In different embodiments, % S is below 0.14 wt %, below 0.08 wt % and even below 0.03 wt %. For some applications, lower % S contents are preferred. In different embodiments, % S is below 0.01 wt %, below 0.009 wt/and even below 0.001 wt %. Obviously, there are cases where the desired nominal content is Owt % or nominal absence of the element as occurs with all optional elements for certain applications. For some applications, a certain content of % Mn+2*% Ni is desirable. In different embodiments, % Mn+2*% Ni is 0.001 wt % or more, 0.08 wt % or more, 0.16 wt % or more, 0.23 wt % or more, 0.58 wt % or more, 0.81 wt % or more, 1.26 wt % or more, 1.56 wt % or more and even 2.16 wt % or more. For some applications, excessive % Mn+2*% Ni seems to deteriorate the mechanical properties. In different embodiments, % Mn+2*% Ni is 4.8 wt % or less, 2.7 wt % or less, 1.6 wt % or less, 1.26 wt % or less, 0.78 wt % or less, 0.69 wt % or less 0.44 wt % or less and even 0.12 wt % or less. For some applications, a certain content of % Cu+% Ni is desirable. In different embodiments, % Cu+% Ni is above 0.06 wt %, above 0.16 wt %, above 0.36 wt %, above 0.51 wt % and even above 0.66 wt %. For some applications, excessive % Cu+% Ni seems to deteriorate the mechanical properties. In different embodiments, % Cu+% Ni is below 3.4 wt %, below 2.4 wt %, below 1.4 wt %, below 0.9 wt % and even below 0.4 wt %. All the upper and lower limits disclosed in the different embodiments can be combined among them in any combination, provided that they are not mutually exclusive, for example % Mn+2*% Ni=0.08-4.8 wt % or % Mn+2*% Ni=0.23-1.26 wt %. For some applications, it works even better when the SP has a composition similar to that of the LP. In an embodiment, LP and SP are the same powder. In an embodiment, the SP has a composition falling inside the compositional range described above for LP. In an embodiment LP and SP have the same composition. In an embodiment, SP is spherical (as previously defined). In an embodiment, SP is a gas atomized powder. In an embodiment, SP comprises powder atomized with a system comprising gas atomization. In an embodiment, SP is a centrifugal atomized powder. In an embodiment, SP comprises powder atomized with a system comprising centrifugal atomization. In an embodiment, SP is a gas carbonyl powder. In an embodiment, SP comprises powder obtained through the carbonyl process. In an embodiment, SP is a carbonyl iron powder. In an embodiment, SP comprises a carbonyl iron powder. In an embodiment, SP is a powder obtained by oxide reduction. In an embodiment, SP is a reduced powder. In an embodiment, SP is a non-spherical powder. Although for most applications the general rules described above for SP apply, in some concrete applications it is better to use somewhat different size constraints for SP of the present composition. In different embodiments, the “powder size critical measure” (as previously defined) for SP is 0.6 nanometers or larger, 52 nanometers or larger, 602 nanometers or larger, 1.2 microns or larger, 6 microns or larger, 12 microns or larger and even 32 microns or larger. For some applications, excessively large size critical measures are difficult to deal especially for some fine detail geometries. In different embodiments, the “powder size critical measure” (as previously defined) for SP is 990 microns or smaller, 490 microns or smaller, 190 microns or smaller, 90 microns or smaller, 19 microns or smaller, 9 microns or smaller, 890 nanometers or smaller and even 490 nanometers or smaller.

In an embodiment, the mixture of LP and SP further comprises a powder selected from the list consisting of AP1, AP2, AP3 and AP4, individually or in any combination, wherein AP1, AP2, AP3 and AP4 are as previously defined.

For several applications, including several tooling, it is interesting to have a steel with a high corrosion resistance combined with very high mechanical properties especially in terms of toughness and yield strength. The combination of high yield strength and toughness has always been one of the paradigms of materials science and adding corrosion resistance to the mix makes the whole challenge even more difficult. While the formulations provided for the powder mix might constitute an invention on their own in some instances also the final overall composition might also constitute a standalone invention. For such applications, the inventor has found that the following mixture (comprising at least LP and SP) is of interest:

LP is a powder having the following composition, all percentages being indicated in weight percent: % Mo: 0-4.9; % W: 0-4.9; % Moeq: 0-4.9; % Ceq: 0.15-2.49; % C: 0.15-2.49; % N: 0-0.9; % B: 0-0.08; % Si: 0-2.5; % Mn: 0-2.9; % Ni: 0-3.9; % Cr: 11.5-19.5; % V: 0-3.9; % Nb: 0-2.9; % Zr: 0-3.9; % Hf: 0-2.9; % Ta: 0-2.9; % S: 0-0.8; % P: 0-0.8; % Pb: 0-1.9; % Cu: 0-3.9; % Bi: 0-0.8; % Se: 0-0.8; % Co: 0-3.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq=% Mo+½*% W: and wherein % REE is as previously defined. In an embodiment, trace elements refers to several elements, unless context clearly indicates otherwise, including but not limited to: H, He, Xe, F, No, Na, Cl, Ar, K, Br, Kr, Sr, Tc, Ru, Rh, Ti, Pd, Ag, I, Ba, Re, Os, Ir, Pt, Au, Hg, Tl, Po, At, Rn, Fr, Ra, Rf, Ob, Sg, Bh, Hs, Li, Be, Mg, Ca, Rb, Zn, Cd, Al, Ga, In, Ge, Sn, Sb, As, Te, Ds, Rg, Cn, Nh, Fl. Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the presence of % Y is desirable, while in other applications it is rather an impurity. In different embodiments, % Y is above 0.012 wt %, above 0.052 wt %, above 0.12 wt %, above 0.22 wt %, above 0.42 wt % and even above 0.82 wt %. For some applications, excessive % Y seems to deteriorate the mechanical properties. In different embodiments, % Y is below 0.74 wt %, below 0.48 wt %, below 0.34 wt %, below 0.18 wt % and even below 0.09 wt %. Obviously, there are cases where the desired nominal content is 0 wt % or nominal absence of the element as occurs with all optional elements for certain applications. For some applications, the presence of % Sc is desirable, while in other applications it is rather an impurity. In different embodiments, % Sc is above 0.012 wt %, above 0.052 wt %, above 0.12 wt %, above 0.22 wt %, above 0.42 wt % and even above 0.82 wt %. For some applications, excessive % Sc seems to deteriorate the mechanical properties. In different embodiments, % Sc is below 0.74 wt %, below 0.48 wt %, below 0.34 wt % and even below 0.18 wt %. Obviously, there are cases where the desired nominal content is Owt % or nominal absence of the element as occurs with all optional elements for certain applications. For some applications, a certain content of % Sc+% Y is desirable. In different embodiments, % Sc+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt/o. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, excessive % REE seems to deteriorate the mechanical properties. In different embodiments, % REE is below 1.4 wt %, below 0.96 wt %, below 0.74 wt % and even below 0.48 wt %. Obviously, there are cases where the desired nominal content is 0 wt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments. % Sc+% Y+% REE is below 1.4 wt %, below 0.96, below 0.74 wt % and even below 0.48 wt %. In some embodiments, the above disclosed for the content of % O, % Cs, % Y, % Sc, % REE and/or % Ti can also be applied to the composition of LP. For some applications, the relation between the atomic content of % O and % Y+% Sc or alternatively % Y or alternatively % Y+% Sc+% REE has to be controlled for optimum mechanical properties according to the formulas previously disclosed. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, excessive % O≤eems to deteriorate the mechanical properties. In different embodiments, % O is below 2990 ppm, below 1900 ppm, below 900 ppm and even below 490 ppm. Obviously, there are cases where the desired nominal content is Owt % or nominal absence of the element as occurs with all optional elements for certain applications. For some applications, higher % C contents are preferred. In different embodiments, % C is above 0.19 wt %, above 0.21 wt %, above 0.31 wt %, above 0.36 wt %, above 0.46 wt % and even above 0.76 wt %. The inventor has found that for applications requiring improved wear resistance, even higher % C contents are preferred. In different embodiments, % C is above 0.86 wt %, above 1.26 wt %, above 1.51 wt % and even above 2.06 wt %. For some applications, an excessive content of % C may adversely affect the mechanical properties. In different embodiments, % C is below 1.9 wt %, below 1.8 wt %, below 1.4 wt % and even below 1.2 wt %. For some applications, lower % C contents are preferred. In different embodiments, % C is below 0.98 wt %, below 0.74 wt %, below 0.48 wt % and even below 0.3 wt %. As previously disclosed, some applications benefit from a low interstitial content level in the generalized way already exposed, but some applications present even better results with somewhat different control over the level of interstitials. In different embodiments, % C is kept below 2890 ppm, below 890 ppm, below 490 ppm, below 196 ppm and even below 96 ppm. The inventor has found that for some applications requiring good wear resistance in combination with high toughness within the present invention, higher % Ceq contents are preferred. In different embodiments, % Ceq is above 0.21 wt %, above 0.26 wt %, above 0.41 wt %, above 0.61 wt % and even above 0.81 wt %. For some applications, higher % Ceq contents are preferred. In different embodiments, % Ceq is above 0.61 wt %, above 0.91 wt %, above 1.36%, above 1.6 and even above 1.86 wt %. On the other hand, for some applications, too high levels of % Ceq lead to impossibility to attain the required nature and perfection of carbides (nitrides, borides, oxides or combinations) regardless of the heat treatment applied. In different embodiments, % Ceq is below 2.1 wt %, below 1.94 wt %, below 1.6 wt % and even below 1.3 wt %. For some applications, lower % Ceq contents are preferred. In different embodiments, % Ceq is below 1.1 wt %, below 0.84 wt %, below 0.64 wt % and even below 0.44 wt %. As previously disclosed, some applications benefit from a low interstitial content level in the generalized way already exposed, but some applications present even better results with somewhat different control over the level of interstitials. In different embodiments, % Ceq is kept below 890 ppm, below 490 ppm, below 90 ppm and even below 40 ppm. For some applications, the presence of % N is desirable, while in other applications it is rather an impurity. In different embodiments, % N is above 0.0002 wt %, above 0.0006 wt %, above 0.001 wt %, above 0.006 wt % and even above 0.01 wt %. For some applications, higher % N contents are preferred. In different embodiments, % N is above 0.04 wt %, above 0.09 wt % above 0.1 wt %, above 0.16 wt %, above 0.26 wt % and even above 0.36 wt/o. For some applications, excessive % N seems to deteriorate the mechanical properties. In different embodiments, % N is below 0.6 wt %, below 0.35 wt %, below 0.19 wt %, below 0.1 wt %, below 0.01 wt % and even below 0.0009 wt %. As previously disclosed, some applications benefit from a low interstitial content level in the generalized way already exposed, but some applications present even better results with somewhat different control over the level of interstitials. In different embodiments, % N is kept below 1900 ppm, below 900 ppm, below 490 ppm, below 190 ppm, below 90 ppm and even below 40 ppm. Obviously, there are cases where the desired nominal content is 0 wt % or nominal absence of the element as occurs with all optional elements for certain applications. It has been surprisingly found, that when the proper geometrical design strategy is employed great results can be achieved by having a controlled level of % B in the LP which is intentional. In different embodiments, % B is kept above 1 ppm, above 11 ppm, above 21 ppm, above 31 ppm and even above 51 ppm. For some applications, it has been found that the final properties of the component, can be surprisingly improved by the usage of rather high % B contents in LP. In different embodiments, % B is kept above 61 ppm, above 111 ppm, above 221 ppm, above 0.06 wt %, above 0.12 wt %, above 0.26 wt % and even above 0.6 wt %. Even in some of those applications, an excessive % B content ends up being detrimental. In different embodiments, % Bis kept below 0.4 wt %, below 0.19 wt %, below 0.09 wt % and even below 0.04 wt %. For some applications, excessive % B seems to deteriorate the mechanical properties. In different embodiments, % B is kept below 400 ppm, below 190 ppm, below 90 ppm, below 40 ppm and even below 9 ppm. Obviously, there are cases where the desired nominal content is Owt % or nominal absence of the element as occurs with all optional elements for certain applications. For some applications, the presence of % Mo is desirable, while in other applications it is rather an impurity. In different embodiments, % Mo is above 0.001 wt %, above 0.12 wt %, above 0.21 wt %, above 0.56 wt % and even above 0.81 wt %. For some applications, higher % Mo contents are preferred for high thermal conductivity. In different embodiments. % Mo is above 1.16 wt %, above 1.51 wt %, above 2.1 wt, above 2.6 wt %, above 3.1 wt % and even above 3.6 wt %. For some applications, excessive % Mo seems to deteriorate the mechanical properties. In different embodiments, % Mo is below 4.4 wt %, below 3.9 wt %, below 3.4 wt %, below 2.9 wt %, below 2.4 wt % and even below 1.9 wt %. For some applications, lower levels are preferred. In different embodiments. % Mo is below 1.4 wt %, below 1.2 wt %, below 0.94 wt %, below 0.49 wt %, below 0.4 wt % and even below 0.1 wt %. Obviously, there are cases where the desired nominal content is Owt % or nominal absence of the element as occurs with all optional elements for certain applications. For some applications, % Mo can be partially replaced with % W. This replacement takes place in terms of % Moeq. In different embodiments, the replacement of molybdenum with % W is lower than 72 wt %, lower than 54 wt %, lower than 36 wt % and even lower than 14 wt %. For applications where thermal conductivity is to be maximized but thermal fatigue has to be regulated, it is normally preferred to have from 1.2 to 3 times more % Mo than % W, but not absence of % W. For some applications, the presence of % Moeq is desirable, while in other applications, it is rather an impurity. In different embodiments, % Moeq is above 0.01 wt %, above 0.1 wt %, above 0.26 wt % and even above 0.51 wt %. For some applications, higher % Moeq contents are preferred for high thermal conductivity. In different embodiments, % Moeq is above 0.76 wt %, above 0.96 wt %, above 1.16 wt % and even above 1.51 wt %. For some applications, even higher % Moeq contents are preferred. In different embodiments, % Moeq is above 2.1 wt %, above 2.56 wt %, above 3.1 wt % and even above 3.56 wt %. For some applications, the inventor has found that the total amount of % Moeq should be controlled and made sure it is not excessive. In different embodiments, % Moeq is below 4.6 wt %, below 4.1 wt %, below 3.8 wt % and even below 3.2 wt %. On the other hand, too high levels of % Moeq will lead to situations where thermal conductivity can be negatively affected. In different embodiments, % Moeq is below 2.8 wt %, below 2.2 wt %, below 1.4 wt %, below 0.8 wt % and even below 0.3 wt %. Some applications benefit from a lower content of % Moeq. In different embodiments, % Moeq is below 0.19 wt %, below 0.09 wt % and even below 0.01 wt %. Obviously, there are cases where the desired nominal content is Owt % or nominal absence as occurs with all optional elements for certain applications. For some applications, particularly when deformation control during the heat treatment is important, it is desirable that % W is not absent. In different embodiments, % W is above 0.06 wt %, above 0.16 wt %, above 0.56 wt % and even above 0.86 wt %. For some applications, higher % W contents are preferred. In different embodiments, % W is above 1.26 wt %, above 1.6 wt %, above 2.1 wt %, above 2.7 wt % above 3.2 wt % and even above 3.7 wt %. For some applications, excessive % W seems to deteriorate the mechanical properties. In different embodiments, % W is below 4.49%, below 3.7 wt %, below 3.3 wt %, below 2.8 wt % and even below 2.4 wt %. For some applications, lower % W contents are preferred. In different embodiments, % W is below 1.84 wt %, below 1.4 wt %, below 1.1 wt %, and even below 0.8 wt %. For some applications, lower levels are preferred. In different embodiments, % W is below 1.2 wt %, below 1 wt %, below 0.9 wt %, below 0.64 wt %, below 0.39 wt % and even below 0.14 wt %. Obviously, there are cases where the desired nominal content is Owt % or nominal absence of the element as occurs with all optional elements for certain applications. For some applications, the presence of % V is desirable, while in other applications it is rather an impurity. In different embodiments, % V is above 0.06 wt %, above 0.16 wt %, above 0.21 wt % and even above 0.28 wt %. For some applications, higher % V contents are preferred. In different embodiments, % V is above 0.86 wt %, above 1.16 wt %, above 1.6 wt %, above 2.1 wt % above 2.6 wt % and even above 3.1 wt %. For some applications, an excessive content of % V may be detrimental. In different embodiments, % V is below 3.4 wt %, below 1.9 wt %, below 1.4 wt % and even below 0.94 wt %. The inventor has found that for some applications, lower % V contents are preferred. In different embodiments, % V is below 0.79 wt %, below 0.44 wt %, below 0.3 wt %, below 0.19 wt % and even below 0.08 wt %. Obviously, there are cases where the desired nominal content is Owt % or nominal absence of the element as occurs with all optional elements for certain applications. For some applications, the presence of % Ni is desirable, while in other applications, it is rather an impurity. In different embodiments, % Ni is above 0.006 wt %, above 0.12 wt %, above 0.26 wt %, above 0.56 wt %, above 1.1 wt % and even above 1.6 wt %. For some applications, higher % Ni contents are preferred. In different embodiments, % Ni is above 1.86 wt %, above 2.16 wt %, above 2.6 wt %, above 2.86 wt % above 3.1 wt % and even above 3.3 wt %. For some applications, an excessive content of % Ni may adversely affect the mechanical properties. In different embodiments, % Ni is below 3.4 wt %, below 2.9 wt %, below 2.2 wt %, below 1.94 wt %, below 1.44 wt % and even below 1.19 wt %. For some applications, lower % Ni contents are preferred. In different embodiments, % Ni is below 0.84 wt %, below 0.49 wt %, below 0.14 wt %, below 0.09 t % and even below 0.001 wt %. Obviously, there are cases where the desired nominal content is Owt % or nominal absence of the element as occurs with all optional elements for certain applications. For some applications, the presence of % Si is desirable, while in other applications, it is rather an impurity. In different embodiments, % Si is above 0.009 wt %, above 0.01 wt %, above 0.26 wt %, above 0.51 wt % and even above 0.76 wt %. For some applications, higher % Si contents are preferred. In different embodiments, % Si is above 1.06 wt %, above 1.3 wt %, above 1.56 wt %, above 1.76 wt % and even above 2.1 wt %. For some applications, an excessive content of % Si may adversely affect the mechanical properties. In different embodiments, % Si is below 2.2 wt %, below 1.9 wt %, below 1.4 wt %, below 1.2 wt % and even below 0.98 wt %. For some applications, lower % Si contents are preferred. In different embodiments, % Si is below 0.84 wt %, below 0.6 wt %, below 0.44 wt %, below 0.2 wt % and even below 0.09 wt %. Obviously, there are cases where the desired nominal content is Owt % or nominal absence of the element as occurs with all optional elements for certain applications. For some applications, the presence of % Mn is desirable, while in other applications it is rather an impurity. In different embodiments, % Mn is above 0.001 wt %, above 0.06 wt %, above 0.26 wt %, above 0.56 wt % and even above 0.86 wt %. For some applications, higher % Mn contents are preferred. In different embodiments, % Mn is above 1.1 wt %, above 1.6 wt %, above 1.9 wt % and even above 2.1 wt %. For some applications, excessive % Mn seems to deteriorate the mechanical properties. In different embodiments. % Mn is below 2.4 wt %, below 1.8 wt %, below 1.3 wt %, below 0.94 wt % and even below 0.79 wt %. For some applications, lower % Mn contents are preferred. In different embodiments, % Mn is below 0.6 wt %, below 0.3 wt %, below 0.24 wt %, below 0.1 wt % and even below 0.04 wt %. Obviously, there are cases where the desired nominal content is Owt % or nominal absence of the element as occurs with all optional elements for certain applications. For some applications, higher % Cr contents are preferred. In different embodiments, % Cr is 11.8 wt % or more, 12.1 wt % or more, 12.6 wt % or more, 13.1 wt % or more and even 13.6 wt % or more. For some applications, even higher % Cr contents are preferred. In different embodiments, % Cr is 14.1 wt % or more, 14.6 wt % or more, 15.1 wt % or more, 15.6 wt % or more, 16.1 wt % or more, 16.6 wt % or more and even 19.1 wt % or more. For some applications, excessive % Cr seems to deteriorate the mechanical properties. In different embodiments, % Cr is below 18.9 wt %, below 18.4 wt %, below 17.9 wt %, below 17.4 wt % and even below 16.9 wt %. For some applications, lower % Cr contents are preferred. In different embodiments, % Cr is below 16.4 wt %, below 15.9 wt %, below 14.9 wt %, below 14.9 wt % and even below 14.4 wt %. For some applications, the presence of % Hf is advantageous. In different embodiments, % Hf is above 0.08 wt %, above 0.25 wt %, above 0.51 wt % and even above 0.76 wt %. The inventor has found that for applications requiring high toughness levels, the % Hf and/or % Zr content should not be very high, as they tend to form big and polygonal primary carbides which act as stress raisers. In different embodiments, % Hf is below 1.9 wt %, below 1.4 wt %, below 0.98 wt %, below 0.49 wt % and even below 0.4 wt %. For some applications, lower % Hf contents are preferred. In different embodiments, % Hf is below 0.24 wt %, below 0.12 wt %, below 0.08 wt % and even below 0.002 wt %. Obviously, there are cases where the desired nominal content is Owt % or nominal absence of the element as occurs with all optional elements for certain applications. For some applications, where the presence of strong carbide formers is advantageous, but where manufacturing cost is of importance the presence of % Zr is desirable. In different embodiments, % Zr is above 0.06 wt %, above 0.1 wt %, above 0.16 wt % and even above 0.52 wt %. For some applications, excessive % Zr seems to deteriorate the mechanical properties. In different embodiments, % Zr is below 2.8 wt %, below 1.9 wt %, below 1.5 wt % and even below 0.94 wt % and even below 0.44 wt %. For some applications, lower % Zr contents are preferred. In different embodiments, % Zr is below 0.3 wt %, below 0.14 wt %, below 0.09 wt % and even below 0.004 wt %. Obviously, there are cases where the desired nominal content is Owt % or nominal absence of the element as occurs with all optional elements for certain applications. For some applications, % Zr and/or % Hf can be partially or totally replaced by % Ta. In different embodiments, more than 26 wt % of the amount of % Hf and/or % Zr are replaced by % Ta, more than 56 wt % of the amount of % Hf and/or % Zr are replaced by % Ta and even more than 76 wt % of the amount of % Hf and/or % Zr are replaced by % Ta. In different embodiments, % Ta+% Zr is above 0.0009 wt %, above 0.009 wt %, above 0.01 wt % above 0.09 wt % and even above 0.11 wt %. For some applications, excessive % Ta+% Zr seems to deteriorate the mechanical properties. In different embodiments, % Ta+% Zr is below 2.4 wt %, below 0.94 wt %, below 0.44 wt % and even below 0.24 wt %. For some applications, the presence of % Nb is desirable, while in other applications it is rather an impurity. In different embodiments, % Nb is above 0.001 wt %, above 0.06 wt %, above 0.26 wt %, above 0.56 wt % and even above 0.86 wt %. For some applications, even higher % Nb contents are preferred. In different embodiments, % Nb is above 1.02 wt %, above 1.6 wt %, above 1.9 wt % and even above 2.1 wt %. For some applications, excessive % Nb seems to deteriorate the mechanical properties. In different embodiments, % Nb is below 2.4 wt %, below 1.8 wt %, below 1.3 wt %, below 0.94 wt % and even below 0.79 wt %. For some applications, lower % Nb contents are preferred. In different embodiments, % Nb is below 0.6 wt %, below 0.3 wt %, below 0.24 wt %, below 0.1 wt % and even below 0.04 wt %. Obviously, there are cases where the desired nominal content is Owt % or nominal absence of the element as occurs with all optional elements for certain applications. For some applications, when it comes to wear resistance the presence of % Hf and/or % Zr has a positive effect. If this is to be greatly increased, then other strong carbide formers like % Ta or even % Nb can also be used. In different embodiments, % Zr+% Hf+% Nb+% Ta is above 0.1 wt %, above 0.56 wt %, above 0.76 wt % and even above 1.1 wt %. For some applications, excessive % Zr+% Hf+% Nb+% Ta seems to deteriorate the mechanical properties. In different embodiments, % Zr+% Hf+% Nb+% Ta is below 1.9 wt %, below 0.94 wt %, below 0.4 wt % and even below 0.12 wt %. For some applications, the presence of % P is desirable, while in other applications, it is rather an impurity. In different embodiments, % P is above 0.0001 wt %, above 0.001 wt %, above 0.009 wt % above 0.01 wt % and even above 0.12 wt %. For some applications, % P and/or % S should be kept as low as possible for high thermal conductivity. In different embodiments. % P is below 0.6 wt %, below 0.3 wt %, below 0.08 wt %, below 0.04 wt %, below 0.009 wt % and even below 0.004 wt %. For some applications, lower % P contents are preferred. In different embodiments. % P is below 0.0009 wt %, below 0.0007 wt % and even below 0.0004 wt %. Obviously, there are cases where the desired nominal content is Owt % or nominal absence of the element as occurs with all optional elements for certain applications. For some applications, the presence of % S is desirable, while in other applications, it is rather an impurity. In different embodiments, % S is above 0.0001 wt %, above 0.002 wt %, above 0.006 wt % above 0.01 wt % and even above 0.11 wt %. For some applications, excessive % S seems to deteriorate the mechanical properties. In different embodiments, % S is below 0.64 wt %, below 0.3 wt %, below 0.14 wt %, below 0.09 wt %, below 0.04 wt % and even below 0.009 wt %. For some applications, lower % S contents are preferred. In different embodiments, % S is below 0.0008 wt %, below 0.0006 wt %, below 0.0004 wt % and even below 0.0001 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0006 wt %, above 0.09 wt %, above 0.12 wt %, above 0.16 wt % and even above 0.52 wt %. For some applications, even higher % Pb contents are preferred. In different embodiments, % Pb is above 0.76 wt %, above 0.9 wt %, above 1.2 wt % and even above 1.4 wt %. For some applications, an excessive content of % Pb may adversely affect the mechanical properties. In different embodiments, % Pb is below 1.4 wt %, below 0.9 wt %, below 0.44 wt %, below 0.24 wt %, below 0.09 wt % and even below 0.02 wt %. Obviously, there are cases where the desired nominal content is 0 wt % or nominal absence of the element as occurs with all optional elements for certain applications. For some applications, an excessive content of % Cu may adversely affect the mechanical properties. In different embodiments, % Cu is below 2.6 wt %, below 1.9 wt %, below 1.2 wt %, below 0.9 wt %, below 0.4 wt % and even below 0.18 wt %. For some applications, lower % Cu contents are preferred. In different embodiments, % Cu is below 0.14 wt %, below 0.08 wt %, below 0.009 wt %, below 0.004 wt % and even below 0.001 wt %. Obviously, there are cases where the desired nominal content is Owt % or nominal absence of the element as occurs with all optional elements for certain applications. For some applications, a certain content of % Cu+% Ni is desirable. In different embodiments, % Cu+% Ni is above 0.26 wt %, above 0.56 wt %, above 0.76 wt % and even above 1.1 wt %. For some applications, excessive % Cu+% Ni seems to deteriorate the mechanical properties. In different embodiments, % Cu+% Ni is below 3.9 wt %, below 2.4 wt %, below 1.4 wt % and even below 0.9 wt %. For some applications, the presence of % Bi is desirable, while in other applications it is rather an impurity. In different embodiments, % Bi is above 0.0002 wt %, above 0.06 wt %, above 0.1 wt %, above 0.14 wt % and even above 0.51 wt %. For some applications, excessive % Bi seems to deteriorate the mechanical properties. In different embodiments, % Bi is below 0.64 wt %, below 0.4 wt %, below 0.24 wt %, below 0.14 wt %, below 0.09 wt % and even below 0.01 wt %. Obviously, there are cases where the desired nominal content is Owt % or nominal absence of the element as occurs with all optional elements for certain applications. For some applications, the presence of % Se is desirable, while in other applications it is rather an impurity. In different embodiments, % Se is above 0.0006 wt %, above 0.05 wt %, above 0.12 wt %, above 0.16 wt % and even above 0.31 wt %. For some applications, excessive % Se seems to deteriorate the mechanical properties. In different embodiments, % Se is below 0.6 wt %, below 0.3 wt %, below 0.14 wt %, below 0.09 wt % and even below 0.009 wt %. Obviously, there are cases where the desired nominal content is Owt % or nominal absence of the element as occurs with all optional elements for certain applications. For some applications, the presence of % Co is desirable, while in other applications it is rather an impurity. In different embodiments, % Co is above 0.01 wt %, above 0.1 wt %, above 0.26 wt %, above 0.51 wt % and even above 1.1 wt %. For some applications, excessive % Co seems to deteriorate the mechanical properties. In different embodiments, % Co is below 2.9 wt %, below 1.4 wt %, below 0.8 wt %, below 0.4 wt %, below 0.19 wt % and even below 0.02 wt %. Obviously, there are cases where the desired nominal content is Owt % or nominal absence of the element as occurs with all optional elements for certain applications. Surprisingly enough, the controlled presence of % B seems to have a strong influence for some applications on the desirable level of % Mn+2*% Ni, some applications strongly benefiting from such presence and some on the contrary suffering from it. In different embodiments, when % B present in a quantity above 12 ppm, % Mn+2*% Ni is kept above 0.01 wt %, above 0.06 wt %, above 0.16 wt %, above 0.26 wt %, above 0.46 wt %, above 0.86 wt % and even above 1.56 wt %. As said, some applications (including some applications involving heat transference) do not benefit from the concurrent presence of high levels of % Mn+2*% Ni and % B. In different embodiments, when % B present in a quantity above 12 ppm, % Mn+2*% Ni is kept below 1.96 wt %, below 0.96 wt %, below 0.46 wt %, below 0.24 wt % and even below 0.09 wt %. All the upper and lower limits disclosed in the different embodiments can be combined among them in any combination, provided that they are not mutually exclusive. Most applications benefit from the general size ranges for the larger powder stated above, but some applications benefit from a somewhat different size distribution. In different embodiments, the “powder size critical measure” (as previously defined) for LP is 2 microns or larger, 22 microns or larger, 42 microns or larger, 52 microns or larger, 102 microns or larger and even 152 microns or larger. For some applications, excessively large size critical measures are difficult to deal especially for some fine detail geometries. In different embodiments, the “powder size critical measure” (as previously defined) for LP is 1990 microns or smaller, 1490 microns or smaller, 990 microns or smaller, 490 microns or smaller, 290 microns or smaller, 190 microns or smaller and even 90 microns or smaller. For some applications it has been found that the manufacturing method for the larger powder has a remarkable influence in the attainable properties of the final component. In an embodiment, LP is a non-spherical powder (as previously defined). In an embodiment, the LP is water atomized. In an embodiment, the LP comprises water atomized powder. In an embodiment, LP is a spherical powder (as previously defined). In an embodiment, the LP is centrifugal atomized. In an embodiment, the LP comprises centrifugal atomized powder. In an embodiment, the LP is mechanically crushed. In an embodiment, the LP comprises crushed powder. In an embodiment, the LP is reduced. In an embodiment, the LP comprises reduced powder. In an embodiment, the LP is gas atomized. In an embodiment, the LP comprises gas atomized powder.

SP is a powder having the following composition, all percentages being indicated in weight percent: % Mo: 0-2.9; % W: 0-2.9; % Moeq: 0-2.9; % Ceq: 0-2.99; % C: 0-2.99; % N: 0-0.2; % B: 0-0.8; % Si: 0-1.9; % Mn: 0-2.9; % Ni: 0-3.9:% Cr: 0-19; % V: 0-1.9; % Nb: 0-0.9; % Zr: 0-0.4; % Hf: 0-0.4; % Ta: 0-0.4; % S: 0-0.2: % P: 0-0.09; % Pb: 0-0.9; % Cu: 0-1.9; % Bi: 0-0.2; % Se: 0-0.2: % Co: 0-1.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq=% Mo+%*% W; and wherein % REE is as previously defined. In an embodiment, trace elements refers to several elements, unless context clearly indicates otherwise, including but not limited to H, He, Xe, F, Ne, Na, Cl, Ar. K, Br, Kr. Sr. Tc, Ru. Rh, Pd, Ag, I. Ba, Re, Os. Ir, Ti, Pt, Au, Hg, Tl, Po, At, Rn, Fr, Ra. Rf, Db, Sg, Bh, Hs, Li, Be, Mg. Ca, Rb, Zn, Cd, Al, Ga, In, Ge, Sn, Sb, As, Te, Ds, Rg, Cn, Nh, Fl, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the presence of % Y is desirable, while in other applications it is rather an impurity. In different embodiments, % Y is above 0.012 wt %, above 0.052 wt %, above 0.12 wt %, above 0.22 wt %, above 0.42 wt % and even above 0.82 wt %. For some applications, excessive % Y seems to deteriorate the mechanical properties. In different embodiments, % Y is below 0.74 wt %, below 0.48 wt %, below 0.34 wt %, below 0.18 wt % and even below 0.09 wt %. Obviously, there are cases where the desired nominal content is Owt % or nominal absence of the element as occurs with all optional elements for certain applications. For some applications, the presence of % Sc is desirable, while in other applications it is rather an impurity. In different embodiments, % Sc is above 0.012 wt %, above 0.052 wt %, above 0.12 wt %, above 0.22 wt %, above 0.42 wt % and even above 0.82 wt %. For some applications, excessive % Sc seems to deteriorate the mechanical properties. In different embodiments, % Sc is below 0.74 wt %, below 0.48 wt %, below 0.34 wt % and even below 0.18 wt %. Obviously, there are cases where the desired nominal content is 0 wt % or nominal absence of the element as occurs with all optional elements for certain applications. For some applications, a certain content of % Sc+% Y is desirable. In different embodiments, % Sc+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt %. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, excessive % REE seems to deteriorate the mechanical properties. In different embodiments, % REE is below 1.4 wt %, below 0.96 wt %, below 0.74 wt % and even below 0.48 wt %. Obviously, there are cases where the desired nominal content is Owt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments, % Sc+% Y+% REE is below 1.4 wt %, below 0.96, below 0.74 wt % and even below 0.48 wt %. In some embodiments, the above disclosed for the content of % O, % Cs, % Y, % Sc, % REE and/or % Ti can also be applied to the composition of SP. For some applications, the relation between the atomic content of % O and % Y+% Sc or alternatively % Y or alternatively % Y+% Sc+% REE has to be controlled for optimum mechanical properties according to the formulas previously disclosed. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, excessive % O≤eems to deteriorate the mechanical properties. In different embodiments, % O is below 2990 ppm, below 1900 ppm, below 900 ppm and even below 490 ppm. Obviously, there are cases where the desired nominal content is Owt % or nominal absence of the element as occurs with all optional elements for certain applications. For some applications, the presence of % C is desirable, while in other applications, it is rather an impurity. In different embodiments, % C is above 0.001 wt %, above 0.002 wt %, above 0.02 wt %, above 0.07 wt %, above 0.1 wt % and even above 0.12 wt %. For some applications, particularly when increasing carbide formers content, also % C has to be increased in order to combine with those elements. In different embodiments, % C is above 0.14 wt %, above 0.16 wt %, above 0.21 wt % and even above 0.28 wt %. For applications requiring improved wear resistance higher % C contents are preferred. In different embodiments, % C is above 0.56 wt %, above 0.76 wt %, above 1.16 wt %, above 1.56 wt % and even above 2.26 wt %. For some applications, excessive % C seems to deteriorate the mechanical properties. In different embodiments, % C is below 2.4 wt %, below 1.98 wt %, below 1.48 wt %, below 0.98 wt and even below 0.69 wt %. For some applications, lower % C contents are preferred. In different embodiments, % C is below 0.49 wt %, below 0.32 wt %, below 0.28 wt %, below 0.23 wt %, below 0.14 wt and even below 0.09 wt %. Obviously, there are cases where the desired nominal content is 0 wt % or nominal absence of the element as occurs with all optional elements for certain applications. For some applications, the presence of % Ceq is desirable, while in other applications, it is rather an impurity. In different embodiments, % Ceq is above 0.001 wt %, above 0.06 wt %, above 0.1 wt %, above 0.21 wt % above 0.23 wt % and even above 0.31 wt %. The inventor has found that for some applications requiring good wear resistance in combination with high toughness within the present invention, higher % Ceq contents are preferred. In different embodiments, % Ceq is above 0.81 wt %, above 1.2 wt %, above 1.6 wt %, above 1.9 wt % and even above 2.1 wt %. On the other hand, for some applications, too high levels of % Ceq lead to impossibility to attain the required nature and perfection of carbides (nitrides, borides, oxides or combinations) regardless of the heat treatment applied. In different embodiments, % Ceq is below 2.44 wt %, below 1.9 wt %, below 1.4 wt %, below 0.9 wt and even below 0.64 wt %. For some applications, lower % Ceq contents are preferred. In different embodiments, % Ceq is less than 0.44 wt %, less than 0.34 wt %, less than 0.29 wt %, below 0.24 wt %, below 0.13 wt and even below 0.09 wt %. Obviously, there are cases where the desired nominal content is Owt % or nominal absence as occurs with all optional elements for certain applications. For some applications, the presence of % N is desirable, while in other applications it is rather an impurity. In different embodiments, % N is above 0.0002 wt %, above 0.0009 wt %, above 0.002 wt %, above 0.008 wt %, above 0.08 wt % and even above 0.02 wt %. For some applications, higher % N contents are preferred. In different embodiments, % N is above 0.07 wt %, above 0.096 wt %, above 0.11 wt % and even above 0.12 wt %. For some applications, excessive % N seems to deteriorate the mechanical properties. In different embodiments, % N is below 0.19 wt %, below 0.15 wt %, below 0.08 wt %, below 0.02 wt % and even below 0.002 wt %. Obviously, there are cases where the desired nominal content is 0 wt % or nominal absence of the element as occurs with all optional elements for certain applications. For some applications, the presence of % Mo is desirable, while in other applications it is rather an impurity. In different embodiments, % Mo is above 0.003 wt %, above 0.1 wt %, above 0.16 wt/o, above 0.26 wt % and even above 0.31 wt %. For some applications, higher % Mo contents are preferred for high thermal conductivity. In different embodiments, % Mo is above 0.36 wt %, above 0.41 wt %, above 0.48 wt, above 0.86 wt %, above 1.56 wt % and even above 2.1 wt %. For some applications, excessive % Mo seems to deteriorate the mechanical properties. In different embodiments, % Mo is below 2.4 wt %, below 2.1 wt %, below 1.9 wt %, below 1.74 wt %, below 1.59 wt % and even below 1.49 wt %. For some applications, lower % Mo contents are preferred. In different embodiments, % Mo is below 1.4 wt %, below 0.74 wt %, below 0.59 wt %, below 0.49 wt %, below 0.29 wt %, below 0.24 wt % and even below 0.1 wt %. Obviously, there are cases where the desired nominal content is Owt % or nominal absence of the element as occurs with all optional elements for certain applications. For some applications, % Mo can be partially replaced with % W. This replacement takes place in terms of % Moeq. In different embodiments, the replacement of % Mo with % W is lower than 69 wt %, lower than 54 wt %, lower than 34 wt % and even lower than 12 wt %. For applications where thermal conductivity is to be maximized but thermal fatigue has to be regulated, it is normally preferred to have from 1.2 to 3 times more % Mo than % W, but not absence of % W. For some applications, the presence of % Moeq is desirable, while in other applications it is rather an impurity. In different embodiments, % Moeq is above 0.002 wt %, above 0.06 wt %, above 0.16 wt % and even above 0.3 wt %. For some applications, higher % Moeq contents are preferred for high thermal conductivity. In different embodiments, % Moeq is above 0.46 wt %, above 0.6 wt %, above 1.3 wt % and even above 1.9 wt %. On the other hand, for some applications, too high levels of % Moeq will lead to situations where thermal conductivity can be negatively affected. In different embodiments. % Moeq is below 2.4 wt %, below 1.9 wt %, below 1.5 wt % and even below 1.2 wt %. For some applications, lower % Moeq contents are preferred. In different embodiments. % Moeq is below 0.84 wt %, below 0.74 wt %, below 0.59 wt %, below 0.4 wt % and even below 0.29 wt %. For some applications, even lower % Moeq contents are preferred. In different embodiments, % Moeq is below 0.24 wt %, below 0.1 wt % and even below 0.09 wt %. Obviously, there are cases where the desired nominal content is Owt % or nominal absence as occurs with all optional elements for certain applications. For some applications, particularly when deformation control during the heat treatment is important, it is desirable that % W is not absent. In different embodiments, % W is above 0.006 wt %, above 0.03 wt %, above 0.1 wt %, above 0.26 wt % and even above 0.36 wt %. For some applications, higher % W contents are preferred. In different embodiments, % W is above 0.4 wt %, above 0.66 wt %, above 1.1 wt % and even above 1.8 wt %. On the other hand, for some applications, excessive % W seems to deteriorate the mechanical properties. In different embodiments, % W is below 2.1 wt %, below 1.9 wt %, 1.4 wt %, below 0.84 wt %, below 0.64 wt % and even below 0.49 wt %. For some applications, lower % W contents are preferred. In different embodiments, % W is below 0.38 wt %, below 0.24 wt %, below 0.09 wt % or even no intentional % W at all. Obviously, there are cases where the desired nominal content is Owt % or nominal absence of the element as occurs with all optional elements for certain applications. The inventor has surprisingly found that for some applications, small amounts of % B have a positive effect on increasing thermal conductivity. In different embodiments, % B is above 2 ppm, above 16 ppm, above 61 ppm and even above 86 ppm. The inventor has found that for some applications, in order to have a noticeable effect on the attainable bainitic microstructure, % B has to be present in somewhat higher contents that what is required for the increase of the hardenability in the ferrite/perlite domain. In different embodiments, % B is above 90 ppm, above 126 ppm, above 206 ppm and even above 326 ppm. For some applications, higher % B contents are preferred. In different embodiments, % B is above 0.09 wt %, above 0.11 wt %, above 0.26 wt % and even above 0.4 wt %. On the other hand, the effect on the toughness can be quite detrimental if excessive borides are formed. In different embodiments, % B is below 0.74 wt %, below 0.6 wt %, below 0.4 wt %, below 0.24 wt % and even below 0.12 wt %. For some applications, lower % B contents are preferred. In different embodiments, % B is below 740 ppm, below 490 ppm, below 140 ppm, below 80 ppm and even below 40 ppm. Obviously, there are cases where the desired nominal content is Owt % or nominal absence of the element as occurs with all optional elements for certain applications. For some applications, the presence of % Si is desirable, while in other applications, it is rather an impurity. In different embodiments, % Si is above 0.009 wt %, above 0.01 wt %, above 0.26 wt %, above 0.51 wt % and even above 0.76 wt %. For some applications, higher % Si contents are preferred. In different embodiments, % Si is above 0.91 wt %, above 1.1 wt %, above 1.36 wt %, above 1.56 wt % and even above 1.6 wt %. For some applications, excessive % Si seems to deteriorate the mechanical properties. In different embodiments, % Si is below 1.6 wt %, below 1.4 wt %, below 1.2 wt %, below 1 wt % and even below 0.98 wt %. For some applications, lower % Si contents are preferred. In different embodiments, % Si is below 0.84 wt %, below 0.6 wt %, below 0.44 wt %, below 0.2 wt % and even below 0.09 wt %. Obviously, there are cases where the desired nominal content is Owt % or nominal absence of the element as occurs with all optional elements for certain applications. For some applications, the presence of % Mn is desirable, while in other applications it is rather an impurity. In different embodiments, % Mn is above 0.001 wt %, above 0.02 wt %, above 0.16 wt %, above 0.36 wt % k, above 0.56 wt % and even above 1.2 wt %. For some applications, higher % Mn contents are preferred. In different embodiments, % Mn is above 1.4 wt %, above 1.6 wt %, above 1.8 wt % and even above 2.1 wt %. For some applications, excessive % Mn seems to deteriorate the mechanical properties. In different embodiments, % Mn is below 2.6 wt %, below 2.2 wt %, below 1.9 wt %, below 1.4 wt % and even below 0.98 wt %. For some applications, lower % Mn contents are preferred. In different embodiments, % Mn is below 0.8 wt %, below 0.6 wt %, below 0.4 wt %, below 0.19 wt % and even below 0.04 wt %. Obviously, there are cases where the desired nominal content is Owt % or nominal absence of the element as occurs with all optional elements for certain applications. For some applications, the presence of % Ni is desirable, while in other applications, it is rather an impurity. In different embodiments, % Ni is above 0.006 wt %, above 0.12 wt %, above 0.26 wt %, above 0.56 wt %, above 1.1 wt % and even above 1.6 wt %. For some applications, higher % Ni contents are preferred. In different embodiments, % Ni is above 1.86 wt %, above 2.16 wt %, above 2.6 wt %, above 2.86 wt % above 3.1 wt % and even above 3.3 wt %. For some applications, an excessive content of % Ni may adversely affect the mechanical properties. In different embodiments, % Ni is below 3.4 wt %, below 2.9 wt %, below 2.2 wt %, below 1.94 wt %, below 1.44 wt % and even below 1.19 wt %. For some applications, lower % Ni contents are preferred. In different embodiments. % Ni is below 0.84 wt %, below 0.49 wt %, below 0.14 wt %, below 0.09 t % and even below 0.001 wt %. Obviously, there are cases where the desired nominal content is Owt % or nominal absence of the element as occurs with all optional elements for certain applications. For some applications, the presence of % Cr is desirable, while in other applications, it is rather an impurity. In different embodiments, % Cr is 0.1 wt % or more, 1.1 wt % or more, 2.6 wt % or more, 3.1 wt % or more and even 5.1 wt % or more. For some applications, higher % Cr contents are preferred. In different embodiments, % Cr is 7.1 wt % or more, 8.6 wt % or more, 10.1 wt % or more, 12.6 wt % or more, 14.1 wt % or more and even 16.1 wt % or more. For some applications, excessive % Cr seems to deteriorate the mechanical properties. In different embodiments, % Cr is below 18.9 wt %, below 16.4 wt %, below 13.9 wt %, below 11.4 wt % and even below 9.9 wt %. For some applications, lower % Cr contents are preferred. In different embodiments, % Cr is below 7.4 wt %, below 5.9 wt %, below 4.4 wt %, below 3.9 wt % and even below 2.4 wt %. For some applications, even lower % Cr contents are preferred. In different embodiments. % Cr is below 1.8 wt %, below 1.2 wt %, below 0.94 wt %, below 0.49 t % and even below 0.01 wt %. Obviously, there are cases where the desired nominal content is Owt % or nominal absence of the element as occurs with all optional elements for certain applications. For some applications, the presence of % V is desirable, while in other applications it is rather an impurity. In different embodiments, % V is 0.0006 wt % or more, 0.01 wt % or more, 0.21 wt % or more, 0.81 wt % or more and even 1.06 wt % or more. For some applications, excessive % V seems to deteriorate the mechanical properties. In different embodiments. % V is below 1.44 wt %, below 1.2 wt %, below 0.9 wt %, below 0.59 wt % and even below 0.19 wt %. Obviously, there are cases where the desired nominal content is Owt % or nominal absence of the element as occurs with all optional elements for certain applications. For some applications, the presence of % Nb is desirable, while in other applications it is rather an impurity. In different embodiments, % Nb is above 0.001 wt %, above 0.006 wt %, above 0.06 wt %, above 0.16 wt % and even above 0.26 wt %. For some applications, excessive % Nb seems to deteriorate the mechanical properties. In different embodiments, % Nb is below 0.4 wt %, below 0.19 wt %, below 0.09 wt %, below 0.009 wt % and even below 0.0009 wt %. Obviously, there are cases where the desired nominal content is Owt % or nominal absence of the element as occurs with all optional elements for certain applications. For some applications, the presence of % Hf is desirable, while in other applications, it is rather an impurity. In different embodiments, % Hf is above 0.008 wt %, above 0.05 wt %, above 0.09 wt % and even above 0.11 wt %. The inventor has found that for applications requiring high toughness levels, the % Hf and/or % Zr content should not be very high, as they tend to form big and polygonal primary carbides which act as stress raisers. In different embodiments, % Hf is below 0.29 wt %, below 0.19 wt %, below 0.14 wt %, below 0.09 wt % and even below 0.04 wt %. For some applications, where the presence of strong carbide formers is advantageous, but where manufacturing cost is of importance the presence of % Zr is desirable. In different embodiments, % Zr is above 0.006 wt %, above 0.06 wt %, above 0.1 wt % and even above 0.12 wt %. For some applications, excessive % Zr seems to deteriorate the mechanical properties In different embodiments, % Zr is below 0.28 wt %, below 0.18 wt %, below 0.13 wt %, below 0.08 wt % and even below 0.03 wt %. For some applications, % Zr and/or % Hf can be partially or totally replaced by % Ta. In different embodiments, more than 25 wt % of the amount of % Hf and/or % Zr are replaced by % Ta, more than 50 wt % of the amount of % Hf and/or % Zr are replaced by % Ta and even more than 75 wt % of the amount of % Hf and/or % Zr are replaced by % Ta. In different embodiments, % Ta+% Zr is above 0.0009 wt %, above 0.009 wt %, above 0.01 wt % above 0.09 wt % and even above 0.11 wt %. For some applications, excessive % Ta+% Zr seems to deteriorate the mechanical properties. In different embodiments, % Ta+% Zr is below 0.4 wt % below 0.18 wt % and even below 0.004 wt %. For some applications, when it comes to wear resistance the presence of % Hf and/or % Zr has a positive effect. If this is to be greatly increased, then other strong carbide formers like % Ta or even % Nb can also be used. In different embodiments, % Zr+% Hf+% Nb+% Ta is above 0.001 wt %, above 0.1 wt %, above 0.36 wt %, above 0.46 wt % and even above 0.76 wt %. For some applications, excessive % Zr+% Hf+% Nb+% Ta seems to deteriorate the mechanical properties. In different embodiments, % Zr+% Hf+% Nb+% Ta is below 0.9 wt %, below 0.46 wt %, below 0.34 wt % below 0.16 wt % and even below 0.001 wt %. For some applications, the presence of % P is desirable, while in other applications, it is rather an impurity. In different embodiments, % P is above 0.0001 wt %, above 0.001 wt %, above 0.008 wt % and even above 0.01 wt %. For some applications, lower % S contents are preferred. For some applications, % P and/or % S should be kept as low as possible for high thermal conductivity. In different embodiments, % P is below 0.08 wt %, below 0.04 wt %, below 0.02 wt % and even below 0.002 wt %. Obviously, there are cases where the desired nominal content is Owt % or nominal absence of the element as occurs with all optional elements for certain applications. For some applications, the presence of % S is desirable, while in other applications, it is rather an impurity. In different embodiments, % S is above 0.006 wt %, above 0.016 wt %, above 0.12 wt % and even above 0.18 wt %. For some applications, lower % S contents are preferred. Indifferent embodiments, % S is below 0.14 wt %, below 0.08 wt %, below 0.04 wt %, below 0.03 wt %, below 0.01 wt % and even below 0.001 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0002 wt %, above 0.06 wt %, above 0.09 wt %, above 0.1 wt % and even above 0.56 wt %. For some applications, excessive % Pb seems to deteriorate the mechanical properties. In different embodiments, % Pb is below 0.6 wt %, below 0.4 wt %, below 0.1 wt %, below 0.09 wt % below 0.04 wt % and even below 0.0009 wt %. Obviously, there are cases where the desired nominal content is Owt % or nominal absence of the element as occurs with all optional elements for certain applications. For some applications, the presence of % Bi is desirable, while in other applications it is rather an impurity. In different embodiments, % Bi is above 0.0009 wt %, above 0.02 wt %, above 0.09 wt % and even above 0.1 wt %, For some applications, excessive % Bi seems to deteriorate the mechanical properties. In different embodiments, % Bi is below 0.14 wt %, below 0.1 wt %, below 0.09 wt %, below 0.009 wt % and even below 0.001 wt %. Obviously, there are cases where the desired nominal content is Owt % or nominal absence of the element as occurs with all optional elements for certain applications. For some applications, the presence of % Se is desirable, while in other applications it is rather an impurity. In different embodiments. % Se is above 0.0001 wt %, above 0.005 wt %, above 0.02 wt %, above 0.08 wt % and even above 0.1 wt %. For some applications, excessive % Se seems to deteriorate the mechanical properties. In different embodiments, % Se is below 0.12 wt %, below 0.07 wt %, below 0.009 wt % and even below 0.0009 wt %. Obviously, there are cases where the desired nominal content is Owt % or nominal absence of the element as occurs with all optional elements for certain applications. For some applications, the presence of % Co is desirable, while in other applications it is rather an impurity. In different embodiments. % Co is above 0.0009 wt %, above 0.05 wt %, above 0.12 wt %, above 0.21 wt %, above 0.56 wt % and even above 1 wt %. For some applications, excessive % Co seems to deteriorate the mechanical properties. In different embodiments, % Co is below 1.4 wt %, below 0.9 wt %, below 0.4 wt %, below 0.2 wt %, below 0.09 wt % below 0.01 wt % and even below 0.004 wt %. Obviously, there are cases where the desired nominal content is Owt % or nominal absence of the element as occurs with all optional elements for certain applications. For some applications, an excessive content of % Cu may adversely affect the mechanical properties. In different embodiments, % Cu is below 1.6 wt %, below 1.4 wt %, below 1.2 wt %, below 0.9 wt %, below 0.4 wt % and even below 0.18 wt %. For some applications, lower % Cu contents are preferred. In different embodiments, % Cu is below 0.14 wt %, below 0.08 wt %, below 0.009 wt %, below 0.004 wt % and even below 0.001 wt %. Obviously, there are cases where the desired nominal content is Owt % or nominal absence of the element as occurs with all optional elements for certain applications. For some applications, a certain content of % Cu+% Ni is desirable. In different embodiments, % Cu+% Ni is above 0.16 wt %, above 0.56 wt %, above 0.76 wt % and even above 1.1 wt %. For some applications, excessive % Cu+% Ni seems to deteriorate the mechanical properties. In different embodiments, % Cu+% Ni is below 3.9 wt %, below 2.4 wt %, below 1.4 wt %, below 0.9 wt % and even below 0.4 wt %. All the upper and lower limits disclosed in the different embodiments can be combined among them in any combination, provided that they are not mutually exclusive. For some applications, it works even better when the SP has a composition similar to that of the LP. In an embodiment, LP and SP are the same powder. In an embodiment, the SP has a composition falling inside the compositional range described above for LP. In an embodiment LP and SP have the same composition. In an embodiment, SP is spherical. In an embodiment, SP is a gas atomized powder. In an embodiment, SP comprises powder atomized with a system comprising gas atomization. In an embodiment, SP is a centrifugal atomized powder. In an embodiment, SP comprises powder atomized with a system comprising centrifugal atomization. In an embodiment, SP is a gas carbonyl powder. In an embodiment, SP comprises powder obtained through the carbonyl process. In an embodiment, SP is a carbonyl iron powder. In an embodiment, SP comprises a carbonyl iron powder. In an embodiment, SP is a powder obtained by oxide reduction. In an embodiment, SP is a reduced powder. In an embodiment, SP is a non-spherical powder. Although for most applications the general rules described above for SP apply, in some concrete applications, it is better to use somewhat different size constraints for SP of the present composition. In different embodiments, the “powder size critical measure” (as previously defined) for SP is 0.6 nanometers or larger, 52 nanometers or larger, 602 nanometers or larger, 1.2 microns or larger, 6 microns or larger, 12 microns or larger and even 32 microns or larger. For some applications, excessively large size critical measures are difficult to deal especially for some fine detail geometries. In different embodiments, the “powder size critical measure” (as previously defined) for SP is 990 microns or smaller, 490 microns or smaller, 190 microns or smaller, 90 microns or smaller, 19 microns or smaller, 9 microns or smaller, 890 nanometers or smaller and even 490 nanometers or smaller.

In an embodiment, the mixture of LP and SP further comprises a powder selected from the list consisting of AP1, AP2, AP3 and AP4, individually or in any combination, wherein AP1, AP2, AP3 and AP4 are as previously defined.

For several applications, including several tooling, it is interesting to have a steel with a high corrosion resistance combined with very high mechanical properties especially in terms of toughness and yield strength. The combination of high yield strength and toughness has always been one of the paradigms of materials science and adding corrosion resistance to the mix makes the whole challenge even more difficult. While the formulations provided for the powder mix might constitute an invention on their own in some instances also the final overall composition might also constitute a standalone invention. For such applications the inventor has found that the following mixture (comprising at least LP and SP) is of interest: LP is a powder having the following composition, all percentages being indicated in weight percent: % Mo: 0.05-2.9; % W: 0-3.9; % Moeq: 0.05-2.9; % Ceq: 0.002-0.14; % C: 0.002-0.09; % N: 0-2.0; % B: 0-0.08: % Si: 0.05-1.5; % Mn: 0.05-1.5; % Ni: 9.5-11.9; % Cr: 10.5-13.5: % Ti: 0.5-2.4; % Al: 0.001-1.5: % V: 0-0.4; % Nb: 0-0.9;% Zr: 0-0.9; % Hf: 0-0.9; % Ta: 0-0.9; % S: 0-0.08; % P: 0-0.08: % Pb: 0-0.9; % Cu: 0-3.9; % Bi: 0-0.08;% Se: 0-0.08; % Co: 0-3.9;% REE: 0-1.4; % Y: 0-0.96; % Sc: 0-0.96: % Cs: 0-1.4; % O: 0-0.299% Y+% Sc+% REE: 0.006-1.9%; the rest consisting of iron and trace elements: wherein % Ceq=% C+0.86*% N+1.2*% B and % Moeq=% Mo+½% W; and wherein % REE is as previously defined. In an embodiment, trace elements refers to several elements, unless context clearly indicates otherwise, including but not limited to: H. He, Xe, F, Ne, Na. Cl, Ar. K, Br, Kr, Sr, Tc, Ru. Rh, Pd, Ag, I, Ba, Re, Os, Ir, Pt, Au, Hg, Tl, Po. At, Rn, Fr, Ra, Rf, Db, Sg, Bh, Hs, Li. Be, Mg, Ca. Rb, Zn, Cd. Ga, In, Ge, Sn, Sb, As, Te, Ds, Rg, On, Nh, Fl, Mc, Lv, Ts. Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the presence of % Y is desirable, while in other applications it is rather an impurity. In different embodiments, % Y is above 0.012 wt %, above 0.052 wt %, above 0.12 wt %, above 0.22 wt %, above 0.42 wt % and even above 0.82 wt %. For some applications, excessive % Y seems to deteriorate the mechanical properties. In different embodiments, % Y is below 0.74 wt %, below 0.48 wt %, below 0.34 wt %, below 0.18 wt % and even below 0.09 wt %. Obviously, there are cases where the desired nominal content is Owt % or nominal absence of the element as occurs with all optional elements for certain applications. For some applications, the presence of % Sc is desirable, while in other applications it is rather an impurity. In different embodiments, % Sc is above 0.012 wt %, above 0.052 wt %, above 0.12 wt %, above 0.22 wt %, above 0.42 wt % and even above 0.82 wt %. For some applications, excessive % Sc seems to deteriorate the mechanical properties. In different embodiments, % Sc is below 0.74 wt %, below 0.48 wt %, below 0.34 wt % and even below 0.18 wt %. Obviously, there are cases where the desired nominal content is 0 wt % or nominal absence of the element as occurs with all optional elements for certain applications. For some applications, a certain content of % Sc+% Y is desirable. In different embodiments, % Sc+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt %. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, excessive % REE seems to deteriorate the mechanical properties. In different embodiments, % REE is below 1.4 wt %, below 0.96 wt %, below 0.74 wt % and even below 0.48 wt %. Obviously, there are cases where the desired nominal content is 0 wt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments, % Sc+% Y+% REE is below 1.4 wt %, below 0.96, below 0.74 wt % and even below 0.48 wt %. In some embodiments, the above disclosed for the content of % O, % Cs, % Y, % Sc, % REE and/or % Ti can also be applied to the composition of LP. For some applications, the relation between the atomic content of % O and % Y+% Sc or alternatively % Y or alternatively % Y+% Sc+% REE has to be controlled for optimum mechanical properties according to the formulas previously disclosed. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, excessive % O≤eems to deteriorate the mechanical properties. In different embodiments, % O is below 2990 ppm, below 1900 ppm, below 900 ppm and even below 490 ppm. Obviously, there are cases where the desired nominal content is 0 wt % or nominal absence of the element as occurs with all optional elements for certain applications. The inventor has found that for applications requiring improved wear resistance higher % C contents are preferred. In different embodiments, % C is above 0.009 wt %, above 0.02 wt %, above 0.021 wt %, above 0.03 wt %, above 0.05 wt %, above 0.06 wt % and even above 0.07 wt %. For some applications, an excessive content of % C may adversely affect the mechanical properties. In different embodiments, % C is below 0.08 wt %, below 0.05 wt %, below 0.02 wt, below 0.01 wt % and even below 0.009 wt %. As previously disclosed, some applications benefit from a low interstitial content level in the generalized way already exposed, but some applications present even better results with somewhat different control over the level of interstitials. In different embodiments, % C is kept below 990 ppm, below 890 ppm, below 490 ppm, below 196 ppm and even below 96 ppm. For some applications, higher % Ceq contents are preferred. In different embodiments, % Ceq is above 0.006 wt %, above 0.01 wt %, above 0.02 wt %, above 0.021 wt %, above 0.09 wt %, above 0.1 wt % and even above 0.11 wt %. On the other hand, for some applications, an excessive content of % Ceq may adversely affect the mechanical properties. In different embodiments, % Ceq is below 0.12 wt %, below 0.1 wt %, below 0.02 wt % and even below 0.009 wt %. As previously disclosed, some applications benefit from a low interstitial content level in the generalized way already exposed, but some applications present even better results with somewhat different control over the level of interstitials. In different embodiments, % Ceq is kept below 890 ppm, below 490 ppm, below 90 ppm and even below 40 ppm. For some applications, the presence of % N is desirable, while in other applications it is rather an impurity. In different embodiments, % N is above 0.0002 wt %, above 0.005 wt %, above 0.025 wt %, above 0.06 wt %, above 0.15 wt % and even above 0.2 wt %. For some applications, higher % N contents are preferred. In different embodiments, % N is above 0.26 wt %, above 0.31 wt %, above 0.4 wt %, above 0.46 wt %, above 0.56 wt % and even above 0.71 wt %. For some applications, even higher % N contents are preferred. In different embodiments, % N is above 0.81 wt %, above 0.91 wt %, above 1.1 wt %, above 1.31 wt % and even above 1.56 wt %. For some applications, excessive % N seems to deteriorate the mechanical properties. In different embodiments, % N is below 1.79 wt %, below 1.49 wt %, below 1.19 wt %, below 0.98 wt %, below 0.9 wt % and even below 0.84 wt %. For some applications, lower % N contents are preferred. In different embodiments, % N is below 0.79 wt %, below 0.74 wt %, below 0.69 wt %, below 0.59 wt %, below 0.49 t % and even below 0.39 wt %. For some applications, even lower % N contents are preferred. In different embodiments, % N is below 0.29 wt %, below 0.12 wt %, below 0.1 wt %, below 0.08 wt %, below 0.02 wt % and even below 0.002 wt %. As previously disclosed, some applications benefit from a low interstitial content level in the generalized way already exposed, but some applications present even better results with somewhat different control over the level of interstitials. In different embodiments, % N is kept below 1900 ppm, below 900 ppm, below 490 ppm, below 190 ppm, below 90 ppm and even below 40 ppm. Obviously, there are cases where the desired nominal content is Owt % or nominal absence of the element as occurs with all optional elements for certain applications. It has been surprisingly found, that when the proper geometrical design strategy is employed great results can be achieved by having a controlled level of % B in the LP which is intentional. In different embodiments, % B is kept above 1 ppm, above 11 ppm, above 21 ppm, above 31 ppm and even above 51 ppm. For some applications, it has been found that the final properties of the component, can be surprisingly improved by the usage of rather high % B contents in LP. In different embodiments, % B is kept above 61 ppm, above 111 ppm, above 221 ppm, above 0.06 wt %, above 0.12 wt %, above 0.26 wt % and even above 0.6 wt %. Even in some of those applications, an excessive % B content ends up being detrimental. In different embodiments, % B is kept below 0.4 wt %, below 0.19 wt %, below 0.09 wt % and even below 0.04 wt %. For some applications, excessive % B seems to deteriorate the mechanical properties. In different embodiments, % B is kept below 400 ppm, below 190 ppm, below 90 ppm, below 40 ppm and even below 9 ppm. Obviously, there are cases where the desired nominal content is Owt % or nominal absence of the element as occurs with all optional elements for certain applications. For some applications, higher % Si contents are preferred. In different embodiments, % Si is above 0.06 wt %, above 0.09 wt %, above 0.26 wt %, above 0.39 wt % above 0.51 wt % and even above 0.76 wt %. For some applications, higher % Si contents are preferred. In different embodiments, % Si is above 0.8 wt %, above 0.86 wt %, above 1.1 wt %, above 1.16 wt % and even above 1.26 wt %. For some applications, excessive % Si seems to deteriorate the mechanical properties. In different embodiments, % Si is below 1.4 wt %, below 1.2 wt %, below 1.1 wt %, below 0.98 wt % and even below 0.8 wt %. For some applications, lower % Si contents are preferred. In different embodiments, % Si is below 0.6 wt %, below 0.4 wt %, below 0.39 wt %, below 0.24 wt % and even below 0.09 wt %. For some applications, higher % Mn contents are preferred. In different embodiments, % Mn is above 0.06 wt %, above 0.07 wt %, above 0.09 wt %, above 0.1 wt %, above 0.16 wt %, above 0.26 wt %, above 0.5 wt % and even above 0.66 wt %. For some applications, even higher % Mn contents are preferred. In different embodiments, % Mn is above 0.51 wt %, above 0.65 wt %, above 0.76 wt %, above 1.1 wt % and even above 1.26 wt %. On the other hand, for some applications, excessive % Mn seems to deteriorate the mechanical properties. In different embodiments, % Mn is below 1.4 wt %, below 1.2 wt %, below 0.9 wt %, below 0.69 wt % and even below 0.5 wt %. For some applications, lower % Mn contents are preferred. In different embodiments, % Mn is below 0.49 wt %, below 0.24 wt %, below 0.1 wt %, below 0.09 wt % and even below 0.04 wt %. The inventor has surprisingly found that in some embodiments, higher % Ni contents have a positive effect on mechanical properties. In different embodiments, % Ni is above 10.0 wt %, above 10.1 wt %, above 10.5 wt %, above 10.6 wt %, above 11.1 wt % and even above 11.3 wt %. For some applications, excessive % Ni seems to deteriorate the mechanical properties. In different embodiments, % Ni is below 11.4 wt %, below 10.9 wt %, below 10.6 wt %, below 10.5 wt %, below 10 wt % and even below 9.9 wt %. Surprisingly enough, the controlled presence of % B seems to have a strong influence for some applications on the desirable level of % Mn+2*% Ni, some applications strongly benefiting from such presence and some on the contrary suffering from it. In different embodiments, when % B present in a quantity above 12 ppm, % Mn+2*% Ni is kept above 0.01 wt %, above 0.06 wt %, above 0.16 wt %, above 0.26 wt %, above 0.46 wt %, above 0.86 wt % and even above 1.56 wt %. As said, some applications (including some applications involving heat transference) do not benefit from the concurrent presence of high levels of % Mn+29% Ni and % B. In different embodiments, when % B present in a quantity above 12 ppm, % Mn+2*% Ni is kept below 1.96 wt %, below 0.96 wt %, below 0.46 wt %, below 0.24 wt % and even below 0.09 wt %. For some applications, higher % Cr contents are preferred. In different embodiments, % Cr is above 10.6 wt %, above 10.8 wt %, above 11.1 wt %, above 11.6 wt %, above 12.0 wt % and even above 12.2 wt %. For some applications, even higher % Cr contents are preferred. In different embodiments, % Cr is above 12.6 wt %, above 13.0 wt %, above 13.1 wt %, above 13.2 wt % and even above 13.3 wt % or more. For some applications, excessive % Cr seems to deteriorate the mechanical properties. In different embodiments. % Cr is below 13.0 wt %, below 12.9 wt %, below 12.4 wt %, below 12.2 wt % and even below 12.0 wt %. For some applications, lower % Cr contents are preferred. In different embodiments, % Cr is below 11.9 wt %, below 11.6 wt %, below 11.4 wt %, below 11.2 wt % and even below 10.9 wt %. For some applications, higher % Ti contents are preferred. In different embodiments, % Ti is above 0.6 wt %, above 0.9 wt %, above 1.1 wt %, above 1.5 wt % above 1.6 wt %, above 1.9 wt % and even above 2.1 wt %. For some applications, excessive % Ti seems to deteriorate the mechanical properties. In different embodiments, % Ti is below 2.1 wt %, below 1.9 wt %, below 1.5 wt %, below 1.3 wt %, below 1.0 wt %, below 0.98 wt % and even below 0.79 wt %. For some applications, higher % Al contents are preferred. In different embodiments, % Al is above 0.06 wt %, above 0.09 wt %, above 0.16 wt %, above 0.26 wt % above 0.39 wt % and even above 0.5 wt %. For some applications, even higher % Al contents are preferred. In different embodiments, % Al is above 0.68 wt %, above 0.86 wt %, above 1.1 wt %, above 1.16 wt % and even above 1.26 wt %. For some applications, excessive % Al seems to deteriorate the mechanical properties. In different embodiments, % Al is below 1.4 wt %, below 1.2 wt %, below 1.1 wt %, below 0.98 wt % and even below 0.8 wt %. For some applications, lower % Al contents are preferred. In different embodiments, % Al is below 0.6 wt %, below 0.5 wt %, below 0.49 wt %, below 0.24 wt % and even below 0.09 wt %. For some applications, the presence of % V is desirable, while in other applications it is rather an impurity. In different embodiments, % V is 0.0006 wt % or more, 0.01 wt % or more, 0.02 wt % or more, 0.1 wt % or more and even 0.16 wt % or more. For some applications, excessive % V seems to deteriorate the mechanical properties. In different embodiments, % V is below 0.34 wt %, below 0.24 wt %, below 0.14 wt %, below 0.09 wt % and even below 0.009 wt %. Obviously, there are cases where the desired nominal content is Owt % or nominal absence of the element as occurs with all optional elements for certain applications. For some applications, the presence of % Nb is desirable, while in other applications it is rather an impurity. In different embodiments, % Nb is above 0.001 wt %, above 0.006 wt %, above 0.06 wt %, above 0.16 wt % and even above 0.26 wt %. For some applications, excessive % Nb seems to deteriorate the mechanical properties. In different embodiments, % Nb is below 0.4 wt %, below 0.19 wt %, below 0.09 wt %, below 0.009 wt % and even below 0.0009 wt %. Obviously, there are cases where the desired nominal content is Owt % or nominal absence of the element as occurs with all optional elements for certain applications. For some applications, the presence of % Hf is advantageous. In different embodiments, % Hf is above 0.008 wt %, above 0.09 wt %, above 0.16 wt % and even above 0.31 wt %. The inventor has found that for applications requiring high toughness levels, the % Hf and/or % Zr content should not be very high, as they tend to form big and polygonal primary carbides which act as stress raisers. In different embodiments, % Hf is below 0.69 wt %, below 0.39 wt %, below 0.14 wt %, below 0.09 wt % and even below 0.04 wt %. Obviously, there are cases where the desired nominal content is Owt % or nominal absence of the element as occurs with all optional elements for certain applications. For some applications, where the presence of strong carbide formers is advantageous, but where manufacturing cost is of importance the presence of % Zr is desirable. In different embodiments, % Zr is above 0.006 wt %, above 0.06 wt %, above 0.1 wt %, above 0.21 wt % and even above 0.36 wt %. For some applications, excessive % Zr seems to deteriorate the mechanical properties. In different embodiments, % Zr is below 0.58 wt %, below 0.38 wt %, below 0.13 wt %, below 0.08 wt % and even below 0.03 wt %. Obviously, there are cases where the desired nominal content is Owt % or nominal absence of the element as occurs with all optional elements for certain applications. For some applications, % Zr and/or % Hf can be partially or totally replaced by % Ta. In different embodiments, more than 25 wt % of the amount of % Hf and/or % Zr are replaced by % Ta, more than 50 wt % of the amount of % Hf and/or % Zr are replaced by % Ta and even more than 75 wt % of the amount of % Hf and/or % Zr are replaced by % Ta. In different embodiments, % Ta+% Zr is above 0.0009 wt %, above 0.09 wt %, above 0.1 wt % above 0.41 wt % and even above 0.61 wt %. For some applications, excessive % Ta+% Zr seems to deteriorate the mechanical properties. In different embodiments, % Ta+% Zr is below 0.9 wt % below 0.28 wt %, below 0.14 wt % and even below 0.004 wt %. For some applications, when it comes to wear resistance the presence of % Hf and/or % Zr has a positive effect. If this is to be greatly increased, then other strong carbide formers like % Ta or even % Nb can also be used. In different embodiments, % Zr+% Hf+% Nb+% Ta is above 0.001 wt %, above 0.1 wt %, above 0.36 wt %, above 0.56 wt % and even above 1.1 wt %. For some applications, excessive % Zr+% Hf+% Nb+% Ta seems to deteriorate the mechanical properties. In different embodiments, % Zr+% Hf+% Nb+% Ta is below 0.9 wt %, below 0.44 wt %, below 0.29 wt % below 0.14 wt % and even below 0.001 wt %. For some applications, the presence of % P is desirable, while in other applications, it is rather an impurity. In different embodiments, % P is above 0.0001 wt %, above 0.001 wt %, above 0.008 wt % and even above 0.01 wt %. For some applications, % P and/or % S should be kept as low as possible for high thermal conductivity. In different embodiments, % P is below 0.06 wt %, below 0.04 wt %, below 0.02 wt % and even below 0.002 wt %. Obviously, there are cases where the desired nominal content is 0 wt % or nominal absence of the element as occurs with all optional elements for certain applications. For some applications, the presence of % S is desirable, while in other applications, it is rather an impurity. In different embodiments, % S is above 0.0001 wt %, above 0.001 wt %, above 0.008 wt % and even above 0.01 wt %. For some applications, excessive % S seems to deteriorate the mechanical properties. In different embodiments, % S is below 0.07 wt %, below 0.05 wt %, below 0.04 wt %, below 0.03 wt %, below 0.01 wt % and even below 0.001 wt %. Obviously, there are cases where the desired nominal content is Owt % or nominal absence of the element as occurs with all optional elements for certain applications. For some applications, the presence of % Cu is desirable, while in other applications it is rather an impurity. In different embodiments, % Cu is above 0.0006 wt %, above 0.05 wt %, above 0.06 wt %, above 0.1 wt % and even above 0.16 wt %. For some applications, higher % Cu contents are preferred. In different embodiments, % Cu is 0.56 wt % or more, 0.91 wt % or more, 1.26 wt % or more, 1.81 wt % or more and even 2.16 wt % or more. For some applications, excessive % Cu seems to deteriorate the mechanical properties. In different embodiments, % Cu is below 3.4 wt %, below 2.9 wt %, below 2.4 wt %, below 1.9 wt %, below 1.4 wt % and even below 0.98 wt %. For some applications, lower % Cu contents are preferred. In different embodiments, % Cu is below 0.64 wt %, below 0.48 wt %, below 0.19 wt %, below 0.05 wt %, below 0.04 wt % and even below 0.001 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0006 wt %, above 0.09 wt %, above 0.12 wt %, above 0.16 wt % and even above 0.52 wt %. For some applications, excessive % Pb seems to deteriorate the mechanical properties. In different embodiments, % Pb is below 0.8 wt %, below 0.64 wt %, below 0.44 wt %, below 0.24 wt %, below 0.09 wt %, below 0.01 wt % and even below 0.004 wt %. Obviously, there are cases where the desired nominal content is Owt % or nominal absence of the element as occurs with all optional elements for certain applications. For some applications, the presence of % Bi is desirable, while in other applications it is rather an impurity. In different embodiments, % Bi is above 0.0001 wt %, above 0.001 wt %, above 0.009 wt %, above 0.01 wt % and even above 0.03 wt %. For some applications, excessive % Bi seems to deteriorate the mechanical properties. In different embodiments, % Bi is below 0.06 wt %, below 0.04 wt %, below 0.02 wt %, below 0.009 wt %, below 0.001 wt % and even below 0.0001 wt %. Obviously, there are cases where the desired nominal content is Owt % or nominal absence of the element as occurs with all optional elements for certain applications. For some applications, the presence of % Se is desirable, while in other applications it is rather an impurity. In different embodiments, % Se is above 0.0001 wt %, above 0.0009 wt %, above 0.001 wt %, above 0.009 wt %, above 0.01 wt % and even above 0.04 wt %. For some applications, excessive % Se seems to deteriorate the mechanical properties. In different embodiments, % Se is below 0.06 wt %, below 0.03 wt %, below 0.009 wt %, below 0.001 wt % and even below 0.0009 wt %. Obviously, there are cases where the desired nominal content is Owt % or nominal absence of the element as occurs with all optional elements for certain applications. For some applications, the presence of % Co is desirable, while in other applications it is rather an impurity. In different embodiments, % Co is above 0.0001 wt %, above 0.001 wt %, above 0.16 wt %, above 0.51 wt % and even above 0.81 wt %. For some applications, higher % Co contents are preferred. In different embodiments, % Co is above 1.1 wt %, above 1.6 wt %, above 1.8 wt %, above 2.1 wt % and even above 2.6 wt %. For some applications, excessive % Co seems to deteriorate the mechanical properties. In different embodiments, % Co is below 3.4 wt % k, below 2.4 wt %, below 1.4 wt %, below 0.8 wt %, below 0.4 wt %, below 0.19 wt % and even below 0.02 wt %. Obviously, there are cases where the desired nominal content is Owt % or nominal absence of the element as occurs with all optional elements for certain applications. For some applications, higher % Mo contents are preferred. In different embodiments, % Mo is above 0.09 wt %, above 0.1 wt %, above 0.26 wt %, above 0.5 wt % and even above 0.51 wt %. For some applications, even higher % Mo contents are preferred. In different embodiments, % Mo is above 0.66 wt %, above 0.81 wt %, above 1.1 wt and even above 1.5 wt %. For some applications, even higher % Mo contents are preferred. In different embodiments, % Mo is above 1.51 wt %, above 1.8 wt %, above 2.1 wt % and even above 2.3 wt %. For some applications, excessive % Mo seems to deteriorate the mechanical properties. In different embodiments, % Mo is below 2.4 wt %, below 1.94 wt %, below 1.5 wt %, below 1.19 wt %, below 0.9 wt % and even below 0.5 wt %. For some applications, lower % Mo contents are preferred. In different embodiments, % Mo is below 0.49 wt %, below 0.4 wt %, below 0.34 wt %, below 0.19 wt %, below 0.1 wt % and even below 0.09 wt %. For some applications, % Mo can be partially replaced with % W. This replacement takes place in terms of % Moeq. In different embodiments, the replacement of % Mo with % W is lower than 69 wt %, lower than 54 wt %, lower than 34 wt % and even lower than 12 wt %. For applications where thermal conductivity is to be maximized but thermal fatigue has to be regulated, it is normally preferred to have from 1.2 to 3 times more % Mo than % W, but not absence of % W. For some applications, higher % Moeq contents are preferred. In different embodiments, % Moeq is above 0.09 wt %, above 0.16 wt %, above 0.31 wt % and even above 0.5 wt %. For some applications, higher % Moeq contents are preferred. In different embodiments, % Moeq is above 0.51 wt %, above 0.81 wt %, above 1.1 wt %, above 1.3 wt % and even above 1.5 wt %. For some applications, even higher % Moeq contents are preferred. In different embodiments, % Moeq is above 1.51 wt %, above 1.8 wt %, above 2.1 wt % and even above 2.3 wt %. For some applications, excessive % Moeq seems to deteriorate the mechanical properties. In different embodiments, % Moeq is below 2.4 wt %, below 1.9 wt %, below 1.5 wt % and even below 1.2 wt %. On the other hand, too high levels of % Moeq will lead to situations where mechanical properties can be negatively affected. In different embodiments, % Moeq is below 0.84 wt %, below 0.5 wt %, below 0.49 wt %, below 0.4 wt %, below 0.29 wt % and even below 0.09 wt %. In different embodiments, % W is above 0.006 wt %, above 0.09 wt %, above 0.16 wt %, above 0.36 wt % and even above 0.4 wt %. For some applications, higher % W contents are preferred. In different embodiments, % W is above 0.66 wt %, above 1.1 wt %, above 1.6 wt %, above 1.86 wt %, above 2.1 wt % and even above 2.8 wt %. On the other hand, for some applications, excessive % W seems to deteriorate the mechanical properties. In different embodiments, % W is below 3.4 wt %, below 2.84 wt %, below 2.4 wt %, below 1.98 wt % and even below 1.49 wt %. Some applications benefit from a lower content of % W. In different embodiments, % W is below 0.98 wt %, below 0.4 wt %, below 0.09 wt % or even no intentional % W at all. Obviously, there are cases where the desired nominal content is Owt % or nominal absence of the element as occurs with all optional elements for certain applications. All the upper and lower limits disclosed in the embodiments can be combined among them in any combination, provided that they are not mutually exclusive. Most applications benefit from the general size ranges for the larger powder stated above, but some applications benefit from a somewhat different size distribution. In different embodiments, the “powder size critical measure” (as previously defined) for LP is 2 microns or larger, 22 microns or larger, 42 microns or larger, 52 microns or larger, 102 microns or larger and even 152 microns or larger. For some applications, excessively large size critical measures are difficult to deal especially for some fine detail geometries. In different embodiments, the “powder size critical measure” (as previously defined) for LP is 1990 microns or smaller, 1490 microns or smaller, 990 microns or smaller, 490 microns or smaller, 290 microns or smaller, 190 microns or smaller and even 90 microns or smaller. For some applications it has been found that the manufacturing method for the larger powder has a remarkable influence in the attainable properties of the final component. In an embodiment, LP is a non-spherical powder (as previously defined). In an embodiment, the LP is water atomized. In an embodiment, the LP comprises water atomized powder. In an embodiment, LP is a spherical powder (as previously defined). In an embodiment, the LP is centrifugal atomized. In an embodiment, the LP comprises centrifugal atomized powder. In an embodiment, the LP is mechanically crushed. In an embodiment, the LP comprises crushed powder. In an embodiment, the LP is reduced. In an embodiment, the LP comprises reduced powder. In an embodiment, the LP is gas atomized. In an embodiment, the LP comprises gas atomized powder.

SP is a powder having the following composition all percentages being indicated in weight percent: % Mo: 0-2.9; % W: 0-2.9; % Moeq: 0-2.9; % Ceq: 0-2.99; % C: 0-2.99; % N: 0-0.2; % B: 0-0.8; % Si: 0-1.9; % Mn: 0-2.9; % Ni: 0-3.9; % Cr: 0-19; % V: 0-1.9; % Nb: 0-0.9; % Zr: 0-0.4;% Hf: 0-0.4; % Ta: 0-0.4; % S: 0-0.2; % P: 0-0.09; % Pb: 0-0.9; % Cu: 0-1.9; % Bi: 0-0.2; % Se: 0-0.2; % Co: 0-1.9; % REE: 0-1.4; % Y: 0-0.96; % Sc: 0-0.96; % Cs: 0-1.4; % O: 0-0.299; the rest consisting of iron and trace elements; wherein % Ceq-% C+0.86*% N+1.2*% B and % Moeq-% Mo+½*% W; and wherein % REE is as previously defined. In an embodiment, trace elements refers to several elements, unless context clearly indicates otherwise, including but not limited to H, He, Xe, F, Ne, Na, Cl, Ar, K, Br, Kr, Sr, Tc, Ru, Rh, Pd, Ag, I, Ba, Re, Os, Ir, Ti, Pt, Au, Hg, Tl, Po, At, Rn, Fr, Ra, Rf, Db, Sg, Bh, Hs, Li, Be, Mg, Ca, Rb, Zn, Cd, Al, Ga, In, Ge, Sn, Sb, As, Te, Ds, Rg, Cn, Nh, Fl, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %%, above 0.06 wt %, above 0.12 wt % and even above 0.55 wt %. For some applications, the presence of % Y is desirable, while in other applications it is rather an impurity. In different embodiments, % Y is above 0.012 wt %, above 0.052 wt %, above 0.12 wt %, above 0.22 wt %, above 0.42 wt % and even above 0.82 wt %. For some applications, excessive % Y seems to deteriorate the mechanical properties. In different embodiments, % Y is below 0.74 wt %, below 0.48 wt %, below 0.34 wt %, below 0.18 wt % and even below 0.09 wt %. Obviously, there are cases where the desired nominal content is Owt % or nominal absence of the element as occurs with all optional elements for certain applications. For some applications, the presence of % Sc is desirable, while in other applications it is rather an impurity. In different embodiments, % Sc is above 0.012 wt %, above 0.052 wt %, above 0.12 wt %, above 0.22 wt %, above 0.42 wt % and even above 0.82 wt %. For some applications, excessive % Sc seems to deteriorate the mechanical properties. In different embodiments, % Sc is below 0.74 wt %, below 0.48 wt %, below 0.34 wt % and even below 0.18 wt %. Obviously, there are cases where the desired nominal content is Owt % or nominal absence of the element as occurs with all optional elements for certain applications. For some applications, a certain content of % Sc+% Y is desirable. In different embodiments, % Sc&+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt %. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, excessive % REE seems to deteriorate the mechanical properties. Indifferent embodiments, % REE is below 1.4 wt %, below 0.96 wt %, below 0.74 wt % and even below 0.48 wt %. Obviously, there are cases where the desired nominal content is Owt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments, % Sc+% Y+% REE is below 1.4 wt %, below 0.96, below 0.74 wt % and even below 0.48 wt %. In some embodiments, the above disclosed for the content of % O, % Cs, % Y, % Sc, % REE and/or % Ti can also be applied to the composition of SP. For some applications, the relation between the atomic content of % O and % Y+% Sc or alternatively % Y or alternatively % Y+% Sc+% REE has to be controlled for optimum mechanical properties according to the formulas previously disclosed. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, excessive % O≤eems to deteriorate the mechanical properties. In different embodiments, % O is below 2990 ppm, below 1900 ppm, below 900 ppm and even below 490 ppm. Obviously, there are cases where the desired nominal content is Owt % or nominal absence of the element as occurs with all optional elements for certain applications. For some applications, the presence of % C is desirable, while in other applications, it is rather an impurity. In different embodiments, % C is above 0.001 wt %, above 0.002 wt %, above 0.02 wt %, above 0.07 wt %, above 0.1 wt % and even above 0.12 wt %. For some applications, particularly when increasing carbide formers content, also % C has to be increased in order to combine with those elements. In different embodiments, % C is above 0.14 wt %, above 0.16 wt %, above 0.21 wt % and even above 0.28 wt %. For applications requiring improved wear resistance higher % C contents are preferred. In different embodiments, % C is above 0.56 wt %, above 0.76 wt %, above 1.16 wt %, above 1.56 wt % and even above 2.26 wt %. For some applications, an excessive content of % C may adversely affect the mechanical properties. In different embodiments, % C is below 2.4 wt %, below 1.98 wt %, below 1.48 wt %, below 0.98 wt and even below 0.69 wt %. For some applications, lower % C contents are preferred. In different embodiments, % C is below 0.49 wt %, below 0.32 wt/o, below 0.28 wt %, below 0.23 wt %, below 0.14 wt and even below 0.09 wt %. Obviously, there are cases where the desired nominal content is Owt % or nominal absence of the element as occurs with all optional elements for certain applications. For some applications, the presence of % Ceq is desirable, while in other applications, it is rather an impurity. In different embodiments, % Ceq is above 0.001 wt %, above 0.06 wt %, above 0.1 wt %, above 0.21 wt % above 0.23 wt % and even above 0.31 wt %. The inventor has found that for some applications requiring good wear resistance in combination with high toughness within the present invention, higher % Ceq contents are preferred. In different embodiments, % Ceq is above 0.81 wt %, above 1.2 wt %, above 1.6 wt %, above 1.9 wt % and even above 2.1 wt %. On the other hand, for some applications, too high levels of % Ceq lead to impossibility to attain the required nature and perfection of carbides (nitrides, borides, oxides or combinations) regardless of the heat treatment applied. In different embodiments, % Ceq is below 2.4 wt %, below 1.9 wt %, below 1.4 wt %, below 0.9 wt and even below 0.64 wt %. For some applications, lower % Ceq contents are preferred. In different embodiments, % Ceq is less than 0.44 wt %, less than 0.34 wt %, less than 0.29 wt %, below 0.24 wt %, below 0.13 wt and even below 0.09 wt %. Obviously, there are cases where the desired nominal content is Owt % or nominal absence as occurs with all optional elements for certain applications. For some applications, the presence of % N is desirable, while in other applications it is rather an impurity. In different embodiments, % N is above 0.0002 wt %, above 0.0009 wt %, above 0.002 wt %, above 0.008 wt %, above 0.08 wt % and even above 0.02 wt %. For some applications, higher % N contents are preferred. In different embodiments, % N is above 0.07 wt %, above 0.096 wt %, above 0.11 wt % and even above 0.12 wt %. For some applications, excessive % N seems to deteriorate the mechanical properties. In different embodiments, % N is below 0.19 wt %, below 0.15 wt %, below 0.08 wt %, below 0.02 wt % and even below 0.002 wt %. Obviously, there are cases where the desired nominal content is 0 wt % or nominal absence of the element as occurs with all optional elements for certain applications. For some applications, the presence of % Mo is desirable, while in other applications it is rather an impurity. In different embodiments, % Mo is above 0.003 wt %, above 0.1 wt %, above 0.16 wt %, above 0.26 wt % and even above 0.31 wt %. For some applications, higher % Mo contents are preferred for high thermal conductivity. In different embodiments, % Mo is above 0.36 wt %, above 0.41 wt %, above 0.48 wt, above 0.86 wt % and even above 1.56 wt %. For some applications, excessive % Mo seems to deteriorate the mechanical properties. In different embodiments, % Mo is below 2.44 wt %, below 1.9 wt %, 1.4 wt %, below 0.74 wt % and even below 0.59 wt %. For some applications, lower levels are preferred. In different embodiments, % Mo is below 0.49 wt %, below 0.29 wt %, 0.24 wt % and even below 0.1 wt %. Obviously, there are cases where the desired nominal content is Owt % or nominal absence of the element as occurs with all optional elements for certain applications. For some applications, % Mo can be partially replaced with % W. This replacement takes place in terms of % Moeq. In different embodiments, the replacement of % Mo with % W is lower than 69 wt %, lower than 54 wt %, lower than 34 wt % and even lower than 12 wt %. For applications where thermal conductivity is to be maximized but thermal fatigue has to be regulated, it is normally preferred to have from 1.2 to 3 times more % Mo than % W, but not absence of % W. For some applications, the presence of % Moeq is desirable, while in other applications it is rather an impurity In different embodiments, % Moeq is above 0.002 wt %, above 0.06 wt %, above 0.16 wt % and even above 0.3 wt %. For some applications, higher % Moeq contents are preferred for high thermal conductivity. In different embodiments, % Moeq is above 0.46 wt %, above 0.6 wt %, above 1.3 wt % and even above 1.9 wt %. For some applications, the inventor has found that the total amount of % Moeq should be controlled and made sure it is not excessive. In different embodiments, % Moeq is below 2.4 wt %, below 1.9 wt %, below 1.5 wt % and even below 1.2 wt %. On the other hand, too high levels of % Moeq will lead to situations where thermal conductivity can be negatively affected. In different embodiments, % Moeq is below 0.84 wt %, below 0.74 wt %, below 0.59 wt %, below 0.4 wt % and even below 0.29 wt %. Some applications benefit from a lower content of % Moeq. In different embodiments, % Moeq is below 0.24 wt %, below 0.1 wt % and even below 0.09 wt %. Obviously, there are cases where the desired nominal content is Owt % or nominal absence as occurs with all optional elements for certain applications. For some applications, particularly when deformation control during the heat treatment is important, it is desirable that % W is not absent. In different embodiments, % W is above 0.006 wt %, above 0.03 wt %, above 0.1 wt %, above 0.26 wt % and even above 0.36 wt %. For some applications, higher % W contents are preferred. In different embodiments, % W is above 0.4 wt %, above 0.66 wt %, above 1.1 wt % and even above 1.8 wt %. On the other hand, for some applications, excessive % W seems to deteriorate the mechanical properties. In different embodiments, % W is below 2.34 wt %, below 1.9 wt %, 1.4 wt %, below 0.84 wt %, below 0.64 wt % and even below 0.49 wt %. Some applications benefit from a lower content of % W. In different embodiments, % W is below 0.38 wt %, below 0.24 wt %, below 0.09 wt % or even no intentional % W at all. Obviously, there are cases where the desired nominal content is Owt % or nominal absence of the element as occurs with all optional elements for certain applications. The inventor has surprisingly found that for some applications, small amounts of % B have a positive effect on increasing thermal conductivity. In different embodiments, % B is above 2 ppm, above 16 ppm, above 61 ppm and even above 86 ppm. The inventor has found that for some applications, in order to have a noticeable effect on the attainable bainitic microstructure, % B has to be present in somewhat higher contents that what is required for the increase of the hardenability in the ferrite/perlite domain. In different embodiments, % B is above 90 ppm, above 126 ppm, above 206 ppm and even above 326 ppm. For some applications, higher % B contents are preferred. In different embodiments, % B is above 0.09 wt %, above 0.11 wt %, above 0.26 wt % and even above 0.4 wt %. On the other hand, the effect on the toughness can be quite detrimental if excessive borides are formed. In different embodiments, % B is below 0.74 wt %, below 0.6 wt %, below 0.4 wt %, below 0.24 wt % and even below 0.12 wt %. For some applications, lower % B contents are preferred. In different embodiments, % B is below 740 ppm, below 490 ppm, below 140 ppm, below 80 ppm and even below 40 ppm. Obviously, there are cases where the desired nominal content is Owt % or nominal absence of the element as occurs with all optional elements for certain applications. For some applications, the presence of % Si is desirable, while in other applications, it is rather an impurity. In different embodiments, % Si is above 0.009 wt %, above 0.01 wt %, above 0.26 wt %, above 0.51 wt % and even above 0.76 wt %. For some applications, higher % Si contents are preferred. In different embodiments, % Si is above 0.91 wt %, above 1.1 wt %, above 1.36 wt %, above 1.56 wt % and even above 1.6 wt %. For some applications, excessive % Si seems to deteriorate the mechanical properties. In different embodiments, % Si is below 1.6 wt %, below 1.4 wt %, below 1.2 wt %, below 1 wt % and even below 0.98 wt %. For some applications, lower % Si contents are preferred. In different embodiments, % Si is below 0.84 wt %, below 0.6 wt %, below 0.44 wt %, below 0.2 wt % and even below 0.09 wt %. Obviously, there are cases where the desired nominal content is Owt % or nominal absence of the element as occurs with all optional elements for certain applications. For some applications, the presence of % Mn is desirable, while in other applications it is rather an impurity. In different embodiments, % Mn is above 0.001 wt %, above 0.02 wt %, above 0.16 wt %, above 0.36 wt %, above 0.56 wt % and even above 1.2 wt %. For some applications, higher % Mn contents are preferred. In different embodiments, % Mn is above 1.4 wt %, above 1.6 wt %, above 1.8 wt % and even above 2.1 wt %. For some applications, excessive % Mn seems to deteriorate the mechanical properties. In different embodiments, % Mn is below 2.6 wt %, below 2.2 wt %, below 1.9 wt %, below 1.4 wt % and even below 0.98 wt %. For some applications, lower % Mn contents are preferred. In different embodiments, % Mn is below 0.8 wt %, below 0.6 wt %, below 0.4 wt %, below 0.19 wt % and even below 0.04 wt %. Obviously, there are cases where the desired nominal content is Owt % or nominal absence of the element as occurs with all optional elements for certain applications. For some applications, the presence of % Ni is desirable, while in other applications, it is rather an impurity. In different embodiments, % Ni is above 0.006 wt %, above 0.12 wt %, above 0.26 wt %, above 0.56 wt %, above 1.1 wt % and even above 1.6 wt %. For some applications, higher % Ni contents are preferred. In different embodiments, % Ni is above 1.86 wt %, above 2.16 wt %, above 2.6 wt %, above 2.86 wt % above 3.1 wt % and even above 3.3 wt %. For some applications, excessive % Ni seems to deteriorate the mechanical properties. In different embodiments, % Ni is below 3.4 wt %, below 2.9 wt %, below 2.2 wt %, below 1.94 wt %, below 1.44 wt % and even below 1.19 wt %. For some applications, lower % Ni contents are preferred. In different embodiments, % Ni is below 0.84 wt %, below 0.49 wt %, below 0.14 wt %, below 0.09 t % and even below 0.001 wt %. Obviously, there are cases where the desired nominal content is Owt % or nominal absence of the element as occurs with all optional elements for certain applications. For some applications, the presence of % Cr is desirable, while in other applications, it is rather an impurity. In different embodiments, % Cr is 0.1 wt % or more, 1.1 wt % or more, 2.6 wt % or more, 3.1 wt % or more and even 5.1 wt % or more. For some applications, higher % Cr contents are preferred. In different embodiments, % Cr is 7.1 wt % or more, 8.6 wt % or more, 10.1 wt % or more, 12.6 wt % or more, 14.1 wt % or more and even 16.1 wt % or more. For some applications, excessive % Cr seems to deteriorate the mechanical properties. In different embodiments, % Cr is below 18.9 wt %, below 16.4 wt %, below 13.9 wt %, below 11.4 wt % and even below 9.9 wt %. For some applications, lower % Cr contents are preferred. In different embodiments, % Cr is below 7.4 wt %, below 5.9 wt %, below 4.4 wt %, below 3.9 wt % and even below 2.4 wt %. For some applications, even lower % Cr contents are preferred. In different embodiments, % Cr is below 1.8 wt %, below 1.2 wt %, below 0.94 wt %, below 0.49 t % and even below 0.01 wt %. Obviously, there are cases where the desired nominal content is Owt % or nominal absence of the element as occurs with all optional elements for certain applications. For some applications, the presence of % V is desirable, while in other applications it is rather an impurity. In different embodiments, % V is 0.0006 wt % or more, 0.01 wt % or more, 0.21 wt % or more, 0.81 wt % or more and even 1.06 wt % or more. For some applications, excessive % V seems to deteriorate the mechanical properties. In different embodiments, % V is below 1.44 wt %, below 1.2 wt %, below 0.9 wt %, below 0.59 wt % and even below 0.19 wt %. Obviously, there are cases where the desired nominal content is Owt % or nominal absence of the element as occurs with all optional elements for certain applications. For some applications, the presence of % Nb is desirable, while in other applications it is rather an impurity. In different embodiments, % Nb is above 0.0001 wt %, above 0.006 wt %, above 0.01 wt %, above 0.16 wt % and even above 0.26 wt %. For some applications, excessive % Nb seems to deteriorate the mechanical properties. In different embodiments, % Nb is below 0.5 wt %, below 0.29 wt %, below 0.09 wt %, below 0.001 wt % and even below 0.0009 wt %. Obviously, there are cases where the desired nominal content is Owt % or nominal absence of the element as occurs with all optional elements for certain applications. For some applications, the presence of % Hf is advantageous. In different embodiments, % Hf is above 0.008 wt %, above 0.05 wt %, above 0.09 wt % and even above 0.11 wt %. The inventor has found that for applications requiring high toughness levels, the % Hf and/or % Zr content should not be very high, as they tend to form big and polygonal primary carbides which act as stress raisers. In different embodiments, % Hf is below 0.29 wt %, below 0.19 wt %, below 0.14 wt %, below 0.09 wt % and even below 0.04 wt %. Obviously, there are cases where the desired nominal content is Owt % or nominal absence of the element as occurs with all optional elements for certain applications. For some applications, where the presence of strong carbide formers is advantageous, but where manufacturing cost is of importance the presence of % Zr is desirable. In different embodiments, % Zr is above 0.006 wt %, above 0.06 wt %, above 0.1 wt % and even above 0.12 wt %. For some applications, excessive % Zr seems to deteriorate the mechanical properties. In different embodiments, % Zr is below 0.28 wt %, below 0.18 wt %, below 0.13 wt %, below 0.08 wt % and even below 0.03 wt %. Obviously, there are cases where the desired nominal content is Owt % or nominal absence of the element as occurs with all optional elements for certain applications. For some applications, % Zr and/or % Hf can be partially or totally replaced by % Ta. In different embodiments, more than 25 wt % of the amount of % Hf and/or % Zr are replaced by % Ta, more than 50 wt % of the amount of % Hf and/or % Zr are replaced by % Ta and even more than 75 wt % of the amount of % Hf and/or % Zr are replaced by % Ta. In different embodiments, % Ta+% Zr is above 0.0009 wt %, above 0.009 wt %, above 0.01 wt % above 0.09 wt % and even above 0.11 wt %. For some applications, excessive % Ta+% Zr seems to deteriorate the mechanical properties. In different embodiments, % Ta+% Zr is below 0.4 wt %, below 0.18 wt % and even below 0.004 wt %. For some applications, when it comes to wear resistance the presence of % Hf and/or % Zr has a positive effect. If this is to be greatly increased, then other strong carbide formers like % Ta or even % Nb can also be used. In different embodiments, % Zr+% Hf+% Nb+% Ta is above 0.001 wt %, above 0.1 wt %, above 0.36 wt %, above 0.46 wt % and even above 0.76 wt %. For some applications, excessive % Zr+% Hf+% Nb+% Ta seems to deteriorate the mechanical properties. In different embodiments, % Zr+% Hf+% Nb+% Ta is below 0.9 wt %, below 0.46 wt %, below 0.34 wt %, below 0.16 wt % and even below 0.001 wt %. For some applications, the presence of % P is desirable, while in other applications, it is rather an impurity. In different embodiments. % P is above 0.0001 wt %, above 0.001 wt %, above 0.008 wt % and even above 0.01 wt %. For some applications, % P and/or % S should be kept as low as possible for high thermal conductivity. In different embodiments, % P is below 0.08 wt %, below 0.04 wt %, below 0.02 wt % and even below 0.002 wt %. Obviously, there are cases where the desired nominal content is Owt % or nominal absence of the element as occurs with all optional elements for certain applications. For some applications, the presence of % S is desirable, while in other applications, it is rather an impurity. In different embodiments. % S is above 0.006 wt %, above 0.016 wt %, above 0.12 wt % and even above 0.18 wt %. For some applications, an excessive content of % S may adversely affect the mechanical properties. In different embodiments. % S is below 0.14 wt %, below 0.08 wt %, below 0.04 wt %, below 0.03 wt %, below 0.01 wt % and even below 0.001 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0002 wt %, above 0.06 wt %, above 0.09 wt %, above 0.1 wt % and even above 0.56 wt %. For some applications, excessive % Pb seems to deteriorate the mechanical properties. In different embodiments, % Pb is below 0.6 wt %, below 0.4 wt %, below 0.1 wt %, below 0.09 wt % below 0.04 wt % and even below 0.0009 wt %. Obviously, there are cases where the desired nominal content is Owt % or nominal absence of the element as occurs with all optional elements for certain applications. For some applications, the presence of % Bi is desirable, while in other applications it is rather an impurity. In different embodiments, % Bi is above 0.0009 wt %, above 0.02 wt %, above 0.09 wt % and even above 0.1 wt %. For some applications, excessive % Bi seems to deteriorate the mechanical properties. In different embodiments, % Bi is below 0.14 wt %, below 0.1 wt %, below 0.09 wt %, below 0.009 wt % and even below 0.001 wt %. Obviously, there are cases where the desired nominal content is Owt % or nominal absence of the element as occurs with all optional elements for certain applications. For some applications, the presence of % Se is desirable, while in other applications it is rather an impurity. In different embodiments, % Se is above 0.0001 wt %, above 0.005 wt %, above 0.02 wt %, above 0.08 wt % and even above 0.1 wt %. For some applications, excessive % Se seems to deteriorate the mechanical properties. In different embodiments, % Se is below 0.12 wt %, below 0.07 wt %, below 0.009 wt % and even below 0.0009 wt %. Obviously, there are cases where the desired nominal content is 0 wt % or nominal absence of the element as occurs with all optional elements for certain applications. For some applications, the presence of % Co is desirable, while in other applications it is rather an impurity. In different embodiments, % Co is above 0.0009 wt %, above 0.05 wt %, above 0.12 wt %, above 0.21 wt %, above 0.56 wt % and even above 1 wt %. For some applications, excessive % Co seems to deteriorate the mechanical properties. In different embodiments, % Co is below 1.4 wt %, below 0.9 wt %, below 0.4 wt %, below 0.2 wt %, below 0.09 wt % below 0.01 wt % and even below 0.004 wt %. Obviously, there are cases where the desired nominal content is Owt % or nominal absence of the element as occurs with all optional elements for certain applications. For some applications, excessive % Cu seems to deteriorate the mechanical properties. In different embodiments, % Cu is below 1.6 wt %, below 1.4 wt %, below 1.2 wt %, below 0.9 wt %, below 0.4 wt % and even below 0.18 wt %. For some applications, lower % Cu contents are preferred. In different embodiments, % Cu is below 0.14 wt %, below 0.08 wt %, below 0.009 wt %, below 0.004 wt % and even below 0.001 wt %. Obviously, there are cases where the desired nominal content is 0 wt % or nominal absence of the element as occurs with all optional elements for certain applications. For some applications, a certain content of % Cu+% Ni is desirable. In different embodiments, % Cu+% Ni is above 0.16 wt %, above 0.56 wt %, above 0.76 wt % and even above 1.1 wt %. For some applications, excessive % Cu+% Ni seems to deteriorate the mechanical properties. In different embodiments, % Cu+% Ni is below 3.9 wt %, below 2.4 wt %, below 1.4 wt %, below 0.9 wt % and even below 0.4 wt %. All the upper and lower limits disclosed in the different embodiments can be combined among them in any combination, provided that they are not mutually exclusive. For some applications, it works even better when the SP has a composition similar to that of the LP. In an embodiment, LP and SP are the same powder. In an embodiment, the SP has a composition falling inside the compositional range described above for LP. In an embodiment LP and SP have the same composition. In an embodiment, SP is spherical (as previously defined). In an embodiment, SP is a gas atomized powder. In an embodiment, SP comprises powder atomized with a system comprising gas atomization. In an embodiment, SP is a centrifugal atomized powder. In an embodiment, SP comprises powder atomized with a system comprising centrifugal atomization. In an embodiment, SP is a gas carbonyl powder. In an embodiment, SP comprises powder obtained through the carbonyl process. In an embodiment, SP is a carbonyl iron powder. In an embodiment, SP comprises a carbonyl iron powder. In an embodiment, SP is a powder obtained by oxide reduction. In an embodiment, SP is a reduced powder. In an embodiment, SP is a non-spherical powder. Although for most applications the general rules described above for SP apply, in some concrete applications, it is better to use somewhat different size constraints for SP of the present composition. In different embodiments, the “powder size critical measure” (as previously defined) for SP is 0.6 nanometers or larger, 52 nanometers or larger 602 nanometers or larger, 1.2 microns or larger, 6 microns or larger, 12 microns or larger and even 32 microns or larger. For some applications, excessively large size critical measures are difficult to deal especially for some fine detail geometries. In different embodiments, the “powder size critical measure” (as previously defined) for SP is 990 microns or smaller, 490 microns or smaller, 190 microns or smaller, 90 microns or smaller, 19 microns or smaller, 9 microns or smaller, 890 nanometers or smaller and even 490 nanometers or smaller.

In an embodiment, the mixture of LP and SP further comprises a powder selected from the list consisting of AP1, AP2, AP3 and AP4, individually or in any combination, wherein AP1, AP2, AP3 and AP4 are as previously defined.

For some applications, the mixing strategy as defined in any of the embodiments above can be advantageously applied to the powders or powder mixtures disclosed throughout this document. Accordingly, all the embodiments disclosed above can be combined among them and with any other embodiment disclosed in this document in any combination, provided that they are not mutually exclusive.

In an embodiment, the steels obtained using any one of the mixtures comprising at least a LP and SP powder described throughout the present document present a microstructure comprising at least 26% bainite, at least 46% bainite, at least 62% bainite, at least 76% bainite, at least 82% bainite and even at least 92% bainite. In an embodiment, the percentages of bainite disclosed above are by volume (vol %). For some applications, a steel having a microstructure comprising high temperature bainite is preferred. In this document high temperature bainite refers to any microstructure formed at temperatures above the temperature corresponding to the bainite nose in the TTT diagram but below the temperature where the ferritic/perlitic transformation ends, but it excludes lower bainite as referred in the literature, which can occasionally form in small amounts also in isothermal treatments at temperatures above the one of the bainitic nose. In different embodiments, high temperature bainite is at least 20%, at least 31%, at least 41%, at least 51% and even at least 66%. For some applications, even higher bainite contents are preferred. In different embodiments, high temperature bainite is at least 76%, at least 86%, at least 91%, at least 96% and even 100%. In an embodiment, all the bainite is high temperature bainite. For some applications, the percentage of high temperature bainite should be limited. In different embodiments, high temperature bainite is less than 98%, less than 79%, less than 69%, less than 59% and even less than 49%. In an embodiment, the percentages of high temperature bainite disclosed above are by volume (vol %). All the embodiments disclosed above can be combined among them in any combination, provided that they are not mutually exclusive, for example, a steel obtained using a powder mixture comprising a LP powder and a SP powder, with a microstructure comprising at least 20 vol % high temperature bainite.

For certain applications, steels with a martensitic microstructure are preferred. In another embodiment, the steels obtained using any one of the mixtures comprising at least a LP and SP powder described throughout the present document present a microstructure comprising at least 26% martensite, at least 46% martensite, at least 62% martensite, at least 76% martensite, at least 82% martensite and even at least 92% martensite. All the embodiments disclosed above can be combined among them in any combination, provided that they are not mutually exclusive, for example, a steel obtained using a powder mixture comprising a LP powder and a SP powder, with a microstructure comprising at least 20 vol % martensite.

For certain applications, what is more relevant is the theorical composition of the powder or powder mixture (as previously disclosed, in some embodiments, LP and SP are the same powder an/or two powders with the same composition). In an embodiment the mixing strategy as defined in preceding paragraphs can also be applied to the theorical composition of the powder or powder mixture (this means that the above disclosed for each and any of LP, SP, AP1, AP2, AP3 and/or AP4 about morphology, sphericity, size, . . . can also be applied to the theorical composition of the powders or powder mixtures disclosed below). In an embodiment, the theorical composition of the powder or powder mixture (the sum of the compositions of all the powders contained in the powder mixture) has the following elements and limitations, all percentages being indicated in weight percent: % C: 0.25-0.8; Mn: 0-1.15; % Si: 0-0.35; Cr: 0.1 max; % Mo: 1.5-6.5; % V: 0-0.6; % W: 0-4; Ni: 0-4; % Co: 0-3; balance Fe and trace elements. Throughout the present paragraph, the term “trace element” refers to any of the elements included in the following list: H, He, Xe, F, S, P, Cu, Pb, Co, Ta, Zr, Nb, Hf, Cs, Y, Sc, Mn, Ni, Mo, W, C, N, B, O, Cr, Fe, Ne, Na, Cl, Ar, K, Br, Kr, Sr, Tc, Ru, Rh, Ti, Pd, Ag, I, Ba, Re, Os, Ir, Pt, Au, Hg, Ti, Po, At, Rn, Fr, Ra, Ac, Th, Pa, U, Np, Pu, Am, Cm, Bk, Cf, Es, Fm, Md, No, Lr, La, Ce, Pr, Nd, Pm, Sm, Eu, Gd, Th, Dy, Ho, Er, Tm, Yb, Lu, Rf, Db, Sg, Bh, Hs, Li, Be, Mg, Ca, Rb, Zn, Cd, Al, Ga, In, Ge, Sn, Bi, Sb, As, Se, Te, Ds, Rg, Cn, Nh, Fl, Mc, Lv, Ts, Og and Mt. In an embodiment, for a given alloy, trace elements include all the elements listed above, excluding those elements listed in the composition of the given alloy. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the alloy. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the alloy. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. In an embodiment, % C is above 0.31 wt %. In an embodiment, % C is above 0.36 wt %. In an embodiment, % C is below 0.69 wt %. In an embodiment, % C is below 0.48 wt %. In an embodiment, % Mn is above 0.16 wt %. In an embodiment, % Mn is above 0.21 wt %. In an embodiment, % Mn is below 1.18 wt %. In an embodiment, % Mn is below 0.94 wt %. In an embodiment. % Si is above 0.01 wt %. In an embodiment. % Si is above 0.12 wt %. In an embodiment, % Si is below 0.52 wt %. In an embodiment, % Si is below 0.27 wt %. In an embodiment, % Cr is above 0.0016 wt %. In an embodiment, % Cr is above 0.0021 wt %. In an embodiment, % Cr is below 0.09 wt %. In an embodiment, % Cr is below 0.04 wt %. In an embodiment, % Mo is above 1.86 wt %. In an embodiment, % Mo is above 2.1 wt %. In an embodiment, % Mo is below 4.9 wt %. In an embodiment, % Mo is below 3.4 wt %. In an embodiment, % V is above 0.12 wt %. In an embodiment, % V is above 0.21 wt %. In an embodiment, % V is below 0.48 wt %. In an embodiment, % V is below 0.23 wt %. In an embodiment, % W is above 0.28 wt %. In an embodiment, % W is above 0.66 wt %. In an embodiment, % W is below 3.4 wt %. In an embodiment, % W is below 2.9 wt %. In an embodiment, % Ni is above 0.32 wt %. In an embodiment, % Ni is above 0.56 wt %. In an embodiment, % Ni is below 3.9 wt %. In an embodiment, % Ni is below 3.4 wt %. In an embodiment, % Co is above 0.08 wt %. In another embodiment, % Co is above 0.16 wt %. In an embodiment, % Co is below 2.4 wt %. In another embodiment, % Co is below 1.9 wt %. In another embodiment, the theorical composition of the powder or powder mixture (the sum of the compositions of all the powders contained in the powder mixture) has the following elements and limitations, all percentages being indicated in weight percent: % C: 0.25-0.55; % Mn: 0.10-1.2; % Si: 0.10-1.20; % Cr: 2.5-5.50; % Mo: 1.00-3.30; % V: 0.30-1.20; balance Fe and trace elements (as previously defined in this paragraph). In an embodiment, % C is above 0.31 wt %. In an embodiment, % C is above 0.36 wt %. In an embodiment, % C is below 0.49 wt %. In an embodiment, % C is below 0.28 wt %. In an embodiment, % Mn is above 0.16 wt %. In an embodiment, % Mn is above 0.26 wt %. In an embodiment, % Mn is below 0.96 wt %. In an embodiment, % Mn is below 0.46 wt %. In an embodiment, % Si is above 0.16 wt %. In an embodiment, % Si is above 0.22 wt %. In an embodiment, % Si is below 0.94 wt %. In an embodiment, % Si is below 0.48 wt %. In an embodiment, % Cr is above 2.86 wt %. In an embodiment, % Cr is above 3.16 wt %. In an embodiment, % Cr is below 4.9 wt %. In an embodiment, % Cr is below 3.4 wt %. In an embodiment, % Mo is above 1.16 wt %. In an embodiment, % Mo is above 1.66 wt %. In an embodiment, % Mo is below 2.9 wt %. In an embodiment, % Mo is below 2.4 wt %. In an embodiment, % V is above 0.42 wt %. In an embodiment, % V is above 0.61 wt %. In an embodiment, % V is below 0.98 wt %. In an embodiment, % V is below 0.64 wt %. In another embodiment, the theorical composition of the powder or powder mixture (the sum of the compositions of all the powders contained in the powder mixture) has the following elements and limitations, all percentages being indicated in weight percent: % C: 0.15-2.35; % Mn: 0.10-2.5; % Si: 0.10-1.0; % Cr: 0.2-17.50; % Mo: 0-1.4; % V: 0-1; % W: 0-2.2: % Ni: 0-4.3; balance Fe and trace elements (as previously defined in this paragraph). In an embodiment, % C is above 0.21 wt %. In an embodiment, % C is above 0.42 wt %. In an embodiment, % C is below 1.94 wt %. In an embodiment, % C is below 1.48 wt %. In an embodiment, % Mn is above 0.18 wt %. In an embodiment, % Mn is above 0.26 wt %. In an embodiment, % Mn is below 1.96 wt %. In an embodiment, % Mn is below 1.46 wt %. In an embodiment, % Si is above 0.16 wt %. In an embodiment, % Si is above 0.22 wt %. In an embodiment, % Si is below 0.94 wt %. In an embodiment, % Si is below 0.48 wt %. In an embodiment, % Cr is above 0.56 wt %. In an embodiment. % Cr is above 1.12 wt %. In an embodiment, % Cr is below 9.8 wt %. In an embodiment, % Cr is below 6.4 wt %. In an embodiment, % Mo is above 0.17 wt %. In an embodiment. % Mo is above 0.56 wt %. In an embodiment, % Mo is below 0.9 wt %. In an embodiment, % Mo is below 0.68 wt %. In an embodiment, % V is above 0.12 wt %. In an embodiment, % V is above 0.21 wt %. In an embodiment, % V is below 0.94 wt %. In an embodiment, % V is below 0.59 wt %. In an embodiment, % W is above 0.18 wt %. In an embodiment, % W is above 0.56 wt %. In an embodiment, % W is below 1.92 wt %. In an embodiment, % W is below 1.44 wt %. In an embodiment, % Ni is above 0.02 wt %. In an embodiment. % Ni is above 0.26 wt %. In an embodiment, % Ni is below 3.9 wt %. In an embodiment, % Ni is below 3.4 wt %. In another embodiment, the theorical composition of the powder or powder mixture (the sum of the compositions of all the powders contained in the powder mixture) has the following elements and limitations, all percentages being indicated in weight percent: % C: 0-0.4: % Mn: 0.1-1; % Si: 0-0.8; % Cr: 0-5.25: % Mo: 0-1.0; % V: 0-0.25; % Ni: 0-4.25: % Al: 0-1.25; balance Fe and trace elements (as defined in this paragraph). In an embodiment, % C is above 0.08 wt %. In an embodiment, % C is above 0.12 wt %. In an embodiment, % C is below 0.34 wt %. In an embodiment, % C is below 0.29 wt %. In an embodiment, % Mn is above 0.18 wt %. In an embodiment, % Mn is above 0.26 wt %. In an embodiment, % Mn is below 0.96 wt %. In an embodiment, % Mn is below 0.46 wt %. In an embodiment, % Si is above 0.006 wt %. In an embodiment, % Si is above 0.02 wt %. In an embodiment, % Si is below 0.64 wt %. In an embodiment, % Si is below 0.44 wt %. In an embodiment, % Cr is above 0.16 wt %. In an embodiment, % Cr is above 0.62 wt %. In an embodiment, % Cr is below 4.96 wt %. In an embodiment, % Cr is below 3.94 wt %. In an embodiment. % Mo is above 0.07 wt %. In an embodiment, % Mo is above 0.16 wt %. In an embodiment, % Mo is below 0.84 wt %. In an embodiment, % Mo is below 0.64 wt %. In an embodiment, % V is above 0.02 wt %. In an embodiment, % V is above 0.09 wt %. In an embodiment, % V is below 0.14 wt %. In an embodiment, % V is below 0.09 wt %. In an embodiment, % Ni is above 0.12 wt %. In an embodiment, % Ni is above 0.16 wt %. In an embodiment, % Ni is below 3.9 wt %. In an embodiment, % Ni is below 3.4 wt %. In an embodiment, % Al is above 0.02 wt %. In an embodiment, % Al is above 0.16 wt %. In an embodiment, % Al is below 0.94 wt %. In an embodiment, % Al is below 0.46 wt %. In another embodiment, the theorical composition of the powder or powder mixture (the sum of the compositions of all the powders contained in the powder mixture) has the following elements and limitations, all percentages being indicated in weight percent: % C: 0.77-1.40; % Si: 0-0.70; % Cr: 3.5-4.5; % Mo: 3.2-10; % V: 0.9-3.60; % W: 0-18.70: % Co: 0-10.50; balance Fe and trace elements (as previously defined in this paragraph). In an embodiment, % C is above 0.91 wt %. In an embodiment, % C is above 1.06 wt %. In an embodiment, % C is below 1.24 wt %. In an embodiment, % C is below 0.94 wt %. In an embodiment, % Si is above 0.06 wt %. In an embodiment, % Si is above 0.12 wt %. In an embodiment, % Si is below 0.44 wt %. In an embodiment, % Si is below 0.34 wt %. In an embodiment, % Cr is above 3.86 wt %. In an embodiment, % Cr is above 4.06 wt %. In an embodiment, % Cr is below 4.34 wt %. In an embodiment, % Cr is below 4.24 wt %. In an embodiment, % Mo is above 3.6 wt %. In an embodiment, % Mo is above 4.2 wt %. In an embodiment, % Mo is below 8.4 wt %. In an embodiment, % Mo is below 7.8 wt %. In an embodiment, % V is above 1.08 wt %. In an embodiment, % V is above 1.21 wt %. In an embodiment, % V is below 2.94 wt %. In an embodiment, % V is below 2.44 wt %. In an embodiment, % W is above 0.31 wt %. In an embodiment, % W is above 0.56 wt %. In an embodiment, % W is below 14.4 wt %. In an embodiment, % W is below 9.4 wt %. In an embodiment, % Co is above 0.01 wt %. In an embodiment, % Co is above 0.16 wt %. In an embodiment, % Co is below 8.44 wt %. In an embodiment, % Co is below 6.4 wt %. In another embodiment, the theorical composition of the powder or powder mixture (the sum of the compositions of all the powders contained in the powder mixture) has the following elements and limitations, all percentages being indicated in weight percent: % C: 0.03 max; % Mn: 0.1 max; % Si: 0.1 max; % Mo: 3.0-5.2; % Ni: 18-19; % Co: 0-12.5; % Ti: 0-2; balance Fe and trace elements (as previously defined in this paragraph). In an embodiment, % C is above 0.0001 wt %. In an embodiment, % C is above 0.0003 wt %. In an embodiment, % C is below 0.01 wt %. In an embodiment, % C is below 0.001 wt %. In an embodiment, % Mn is above 0.00001 wt %. In an embodiment, % Mn is above 0.0003 wt %. In an embodiment, % Mn is below 0.01 wt %. In an embodiment, % Mn is below 0.008 wt %. In an embodiment, % Si is above 0.00002 wt %. In an embodiment, % Si is above 0.0004 wt %. In an embodiment, % Si is below 0.011 wt %. In an embodiment, % Si is below 0.004 wt %. In an embodiment, % Mo is above 3.52 wt %. In an embodiment, % Mo is above 4.12 wt %. In an embodiment, % Mo is below 4.94 wt %. In an embodiment, % Mo is below 4.44 wt %. In an embodiment, % Ni is above 18.26 wt %. In an embodiment, % Ni is above 18.56 wt %. In an embodiment, % Ni is below 18.87 wt %. In an embodiment, % Ni is below 18.73 wt %. In an embodiment, % Co is above 0.01 wt %. In an embodiment, % Co is above 0.26 wt %. In an embodiment, % Co is below 9.44 wt %. In an embodiment, % Co is below 7.4 wt %. In an embodiment, % Ti is above 0.08 wt %. In an embodiment, % Ti is above 0.12 wt %. In an embodiment, % Ti is below 1.84 wt %. In an embodiment, % Ti is below 1.44 wt %. In another embodiment, the theorical composition of the powder or powder mixture (the sum of the compositions of all the powders contained in the powder mixture) has the following elements and limitations, all percentages being indicated in weight percent: % C: 1.5-1.85; % Mn: 0.15-0.5; % Si: 0.15-0.45; % Cr: 3.5-5.0; % Mo: 0-6.75; % V: 4.5-5.25; % W: 11.5-13.00; % Co: 0-5.25; balance Fe and trace elements (as defined in this paragraph). In an embodiment, % C is above 1.56 wt %. In an embodiment, % C is above 1.66 wt %. In an embodiment. % C is below 1.78 wt %. In an embodiment, % C is below 1.74 wt %. In an embodiment, % Mn is above 0.21 wt %. In an embodiment, % Mn is above 0.26 wt %. In an embodiment, % Mn is below 0.41 wt %. In an embodiment, % Mn is below 0.29 wt %. In an embodiment, % Si is above 0.18 wt %. In an embodiment, % Si is above 0.21 wt %. In an embodiment. % Si is below 0.39 wt %. In an embodiment, % Si is below 0.34 wt %. In an embodiment, % Cr is above 3.66 wt %. In an embodiment, % Cr is above 3.86 wt %. In an embodiment. % Cr is below 4.92 wt %. In an embodiment, % Cr is below 3.92 wt %. In an embodiment. % V is above 4.62 wt %. In an embodiment, % V is above 4.86 wt %. In an embodiment, % V is below 5.18 wt %. In an embodiment, % V is below 4.94 wt %. In an embodiment, % W is above 11.61 wt %. In an embodiment, % W is above 11.86 wt %. In an embodiment. % W is below 12.94 wt %. In an embodiment, % W is below 12.48 wt %. In an embodiment, % Co is above 0.1 wt %. In an embodiment, % Co is above 0.26 wt %. In an embodiment, % Co is below 4.44 wt %. In an embodiment, % Co is below 3.4 wt %. In another embodiment, the theorical composition of the powder or powder mixture (the sum of the compositions of all the powders contained in the powder mixture) has the following elements and limitations, all percentages being indicated in weight percent: % C: 0-0.6; % Mn: 0-1.5; % Si: 0-1; % Cr: 11.5-17.5; % Mo: 0-1.5: % V: 0-0.2; % Ni: 0-6.0; balance Fe and trace elements (as previously defined in this paragraph). In an embodiment, % C is above 0.02 wt %. In an embodiment, % C is above 0.12 wt %. In an embodiment, % C is below 0.48 wt %. In an embodiment, % C is below 0.44 wt %. In an embodiment, % Mn is above 0.01 wt %. In an embodiment, % Mn is above 0.16 wt %. In an embodiment, % Mn is below 1.22 wt %. In an embodiment, % Mn is below 0.93 wt %. In an embodiment, % Si is above 0.08 wt %. In an embodiment, % Si is above 0.11 wt %. In an embodiment, % Si is below 0.89 wt %. In an embodiment, % Si is below 0.46 wt %. In an embodiment, % Cr is above 11.86 wt %. In an embodiment, % Cr is above 12.56 wt %. In an embodiment, % Cr is below 16.94 wt %. In an embodiment, % Cr is below 14.96 wt %. In an embodiment, % Mo is above 0.09 wt %. In an embodiment, % Mo is above 0.28 wt %. In an embodiment, % Mo is below 1.22 wt %. In an embodiment, % Mo is below 0.94 wt %. In an embodiment, % V is above 0.0018 wt %. In an embodiment, % V is above 0.009 wt %. In an embodiment, % V is below 0.14 wt %. In an embodiment, % V is below 0.09 wt %. In an embodiment, % Ni is above 0.09 wt %. In an embodiment, % Ni is above 0.16 wt %. In an embodiment, % Ni is below 4.48 wt %. In an embodiment, % Ni is below 3.92 wt %. In another embodiment, the theorical composition of the powder or powder mixture (the sum of the compositions of all the powders contained in the powder mixture) has the following elements and limitations, all percentages being indicated in weight percent: C: 0.015 max: Mn: 0.5-1.25: Si: 0.2-1; Cr: 11-18; Mo: 0-3.25: Ni: 3.0-9.5; Ti: 0-1.40: Al: 0-1.5: Cu: 0-5; balance Fe and trace elements (as previously defined in this document). In an embodiment, % C is above 0.002 wt %. In an embodiment, % C is above 0.0036 wt %. In an embodiment, % C is below 0.001 wt %. In an embodiment, % C is below 0.003 wt %. In an embodiment, % Mn is above 0.61 wt %. In an embodiment, % Mn is above 0.77 wt %. In an embodiment, % Mn is below 1.18 wt %. In an embodiment, % Mn is below 0.96 wt %. In an embodiment, % Si is above 0.28 wt %. In an embodiment, % Si is above 0.31 wt %. In an embodiment, % Si is below 0.89 wt %. In an embodiment, % Si is below 0.46 wt %. In an embodiment, % Cr is above 11.58 wt %. In an embodiment, % Cr is above 12.62 wt %. In an embodiment, % Cr is below 16.92 wt %. In an embodiment, % Cr is below 14.92 wt %. In an embodiment, % Mo is above 0.19 wt %. In an embodiment, % Mo is above 0.28 wt %. In an embodiment, % Mo is below 2.82 wt %. In an embodiment, % Mo is below 1.88 wt %. In an embodiment, % Ni is above 3.64 wt %. In an embodiment, % Ni is above 5.62 wt %. In an embodiment, % Ni is below 8.82 wt %. In an embodiment, % Ni is below 8.21 wt %. In an embodiment, % Ti is above 0.08 wt %. In an embodiment, % Ti is above 0.12 wt %. In an embodiment, % Ti is below 1.34 wt %. In an embodiment, % Ti is below 1.22 wt %. In an embodiment, % Al is above 0.06 wt %. In an embodiment, % Al is above 0.14 wt %. In an embodiment, % Al is below 1.24 wt %. In an embodiment, % Al is below 1.12 wt %. In an embodiment, % Cu is above 0.09 wt %. In an embodiment, % Cu is above 0.12 wt %. In an embodiment, % Cu is below 4.38 wt %. In an embodiment, % Cu is below 3.82 wt %. In another embodiment, the theorical composition of the powder or powder mixture (the sum of the compositions of all the powders contained in the powder mixture) has the following elements and limitations, all percentages being indicated in weight percent: % Mg: 0.006-10.6; % Si: 0.006-23; % Ti: 0.002-0.35; % Cr: 0.01-0.40; % Mn-0.002-1.8; % Fe: 0.006-1.5; % Ni: 0-3.0; % Cu: 0.006-10.7; % Zn: 0.006-7.8; % Sn: 0-7; % Zr: 0-0.5; balance aluminium (Al) and trace elements (as previously defined in this paragraph). In an embodiment, % Mg is above 0.009 wt %. In an embodiment, % Mg is above 1.62 wt %. In an embodiment, % Mg is below 8.38 wt %. In an embodiment, % Mg is below 4.82 wt %. In an embodiment, % Si is above 0.02 wt %. In an embodiment, % Si is above 1.64 wt %. In an embodiment, % Si is below 19.8 wt %. In an embodiment, % Si is below 9.8 wt %. In an embodiment. Ti is above 0.008 wt %. In an embodiment, % Ti is above 0.12 wt %. In an embodiment, % Ti is below 0.29 wt %. In an embodiment, % Ti is below 0.24 wt %. In an embodiment, % Cr is above 0.03 wt %. In an embodiment, % Cr is above 0.12 wt %. In an embodiment, % Cr is below 0.34 wt %. In an embodiment, % Cr is below 0.23 wt %. In an embodiment, % Mn is above 0.01 wt %. In an embodiment, % Mn is above 0.21 wt %. In an embodiment, % Mn is below 1.38 wt %. In an embodiment, % Mn is below 0.96 wt %. In an embodiment, % Fe is above 0.01 wt %. In an embodiment, % Fe is above 0.57 wt %. In an embodiment, % Fe is below 1.38 wt %. In an embodiment, % Fe is below 0.96 wt %. In an embodiment, % Ni is above 0.01 wt %. In an embodiment, % Ni is above 0.41 wt %. In an embodiment, % Ni is below 2.46 wt %. In an embodiment, % Ni is below 1.92 wt %. In an embodiment, % Cu is above 0.08 wt %. In an embodiment, % Cu is above 0.16 wt %. In an embodiment, % Cu is below 8.38 wt %. In an embodiment, % Cu is below 4.82 wt %. In an embodiment, % Zn is above 0.09 wt %. In an embodiment, % Zn is above 0.16 wt %. In an embodiment, % Zn is below 6.38 wt %. In an embodiment, % Zn is below 3.82 wt %. In an embodiment, % Sn is above 0.001 wt %. In an embodiment, % Sn is above 0.12 wt %. In an embodiment, % Sn is below 4.38 wt %. In an embodiment, % Sn is below 3.42 wt %. In an embodiment, % Zr is above 0.009 wt %. In an embodiment, % Zr is above 0.06 wt %. In an embodiment, % Zr is below 0.38 wt %. In an embodiment, % Zr is below 0.24 wt %. In another embodiment, the theorical composition of the powder or powder mixture (the sum of the compositions of all the powders contained in the powder mixture) has the following elements and limitations, all percentages being indicated in weight percent: Zn: 0-40; Ni: 0-31; Al: 0-13; Sn: 0-10; Fe: 0-5.5; Si: 0-4; Pb: 0-4; Mn: 0-3; Co: 0-2.7; Be: 0-2.75: Cr: 0-1; balance copper (% Cu) and trace elements (as previously defined in this paragraph). In an embodiment, % Zn is above 0.29 wt %. In an embodiment, % Zn is above 1.26 wt %. In an embodiment, % Zn is below 26.38 wt %. In an embodiment, % Zn is below 13.42 wt %. In an embodiment, % Ni is above 0.1 wt %. In an embodiment, % Ni is above 2.61 wt %. In an embodiment, % Ni is below 24.46 wt %. In an embodiment, % Ni is below 16.92 wt %. In an embodiment, % Al is above 0.6 wt %. In an embodiment, % Al is above 2.14 wt %. In an embodiment, % Al is below 8.24 wt %. In an embodiment, % Al is below 5.12 wt %. In an embodiment, % Sn is above 0.01 wt %. In an embodiment, % Sn is above 0.32 wt %. In an embodiment, % Sn is below 6.38 wt %. In an embodiment, % Sn is below 4.42 wt %. In an embodiment, % Fe is above 0.1 wt %. In an embodiment, % Fe is above 0.67 wt %. In an embodiment, % Fe is below 3.38 wt %. In an embodiment, % Fe is below 2.96 wt %. In an embodiment, % Si is above 0.2 wt %. In an embodiment. % Si is above 0.64 wt %. In an embodiment, % Si is below 2.8 wt %. In an embodiment, % Si is below 1.8 wt %. In an embodiment, % Pb is above 0.002 wt %. In an embodiment, % Pb is above 0.4 wt %. In an embodiment, % Pb is below 2.8 wt %. In an embodiment, % Pb is below 1.4 wt %. In an embodiment, % Mn is above 0.001 wt %. In an embodiment, % Mn is above 0.26 wt %. In an embodiment, % Mn is below 2.38 wt %. In an embodiment, % Mn is below 0.94 wt %. In an embodiment, % Co is above 0.0001 wt %. In an embodiment, % Co is above 0.16 wt %. In an embodiment, % Co is below 2.18 wt %. In an embodiment, % Co is below 0.84 wt %. In an embodiment, % Be is above 0.0006 wt %. In an embodiment, % Be is above 0.12 wt %. In an embodiment, % Be is below 1.84 wt %. In an embodiment, % Be is below 0.44 wt %. In an embodiment, % Cr is above 0.003 wt %. In an embodiment, % Cr is above 0.22 wt %. In an embodiment, % Cr is below 0.44 wt %. In an embodiment, % Cr is below 0.19 wt %. In another embodiment, the theorical composition of the powder or powder mixture (the sum of the compositions of all the powders contained in the powder mixture) has the following elements and limitations, all percentages being indicated in weight percent: % Be: 0.15-3.0; % Co: 0-3; % Ni: 0-2.2: % Pb: 0-0.6: % Fe: 0-0.25: % Si: 0-0.35: % Sn: 0-0.25, % Zr 0-0.5: balance copper (Cu) and trace elements (as previously defined in this paragraph). In an embodiment, % Be is above 0.21 wt %. In an embodiment, % Be is above 0.52 wt %. In an embodiment, % Be is below 2.44 wt %. In an embodiment, % Be is below 1.44 wt %. In an embodiment, % Co is above 0.001 wt %. In an embodiment, % Co is above 0.12 wt %. In an embodiment, % Co is below 2.18 wt %. In an embodiment, % Co is below 0.84 wt %. In an embodiment, % Ni is above 0.001 wt %. In an embodiment, % Ni is above 0.61 wt %. In an embodiment, % Ni is below 1.46 wt %. In an embodiment, % Ni is below 0.92 wt %. In an embodiment, % Pb is above 0.009 wt %. In an embodiment, % Pb is above 0.26 wt %. In an embodiment, % Pb is below 0.48 wt %. In an embodiment, % Pb is below 0.29 wt %. In an embodiment, % Fe is above 0.001 wt %. In an embodiment, % Fe is above 0.09 wt %. In an embodiment, % Fe is below 0.19 wt %. In an embodiment, % Fe is below 0.14 wt %. In an embodiment, % Si is above 0.002 wt %. In an embodiment, % Si is above 0.04 wt %. In an embodiment, % Si is below 0.24 wt %. In an embodiment, % Si is below 0.09 wt %. In an embodiment, % Sn is above 0.001 wt %. In an embodiment, % Sn is above 0.03 wt %. In an embodiment, % Sn is below 0.23 wt %. In an embodiment, % Sn is below 0.08 wt %. In an embodiment, % Zr is above 0.009 wt %. In an embodiment, % Zr is above 0.08 wt %. In an embodiment, % Zr is below 0.38 wt %. In an embodiment, % Zr is below 0.19 wt %. In another embodiment, the theorical composition of the powder or powder mixture (the sum of the compositions of all the powders contained in the powder mixture) has the following elements and limitations, all percentages being indicated in weight percent: % Cr: 9-33; % W: 0-26; % Mo: 0-29; % C: 0-3.5; % Fe: 0-9; % Ni: 0-35; % Si: 0-3.9; Mn: 0-2.5: % B: 0-1: % V: 0-4.2: % Nb/% Ta: 0-5.5; balance cobalt (Co) and trace elements (as previously defined in this paragraph). In an embodiment, % Cr is above 12.6 wt %. In an embodiment, % Cr is above 16.6 wt %. In an embodiment, % Cr is below 24.8 wt %. In an embodiment, % Cr is below 14.9 wt %. In an embodiment, % W is above 2.64 wt %. In an embodiment, % W is above 8.6 wt %. In an embodiment, % W is below 19.8 wt %. In an embodiment, % W is below 12.9 wt %. In an embodiment, % Mo is above 3.16 wt %. In an embodiment, % Mo is above 10.6 wt %. In an embodiment, % Mo is below 19.8 wt %. In an embodiment, % Mo is below 13.9 wt %. In an embodiment, % C is above 0.001 wt %. In an embodiment, % C is above 0.02 wt %. In an embodiment, % C is below 1.88 wt %. In an embodiment, % C is below 0.88 wt %. In an embodiment, % Fe is above 0.1 wt %. In an embodiment, % Fe is above 0.59 wt %. In an embodiment, % Fe is below 6.8 wt %. In an embodiment, % Fe is below 4.42 wt %. In an embodiment, % Ni is above 0.01 wt %. In an embodiment, % Ni is above 1.26 wt %. In an embodiment, % Ni is below 18.8 wt %. In an embodiment, % Ni is below 9.8 wt %. In an embodiment. % Si is above 0.02 wt %. In an embodiment. % Si is above 0.09 wt %. In an embodiment, % Si is below 1.94 wt %. In an embodiment, % Si is below 0.94 wt %. In an embodiment, % Mn is above 0.0001 wt %. In an embodiment. % Mn is above 0.16 wt %. In an embodiment, % Mn is below 2.18 wt %. In an embodiment, % Mn is below 0.88 wt %. In an embodiment, % B is above 0.0001 wt %. In an embodiment, % B is above 0.006 wt %. In an embodiment, % B is below 0.42 wt %. In an embodiment, % B is below 0.18 wt %. In an embodiment, % V is above 0.01 wt %. In an embodiment, % V is above 0.26 wt %. In an embodiment, % V is below 2.42 wt %. In an embodiment, % V is below 1.48 wt %. In an embodiment. % Nb*% Ta is above 0.01 wt %. In an embodiment, % Nb/% Ta is above 0.26 wt %. In an embodiment, % Nb % Ta is below 1.42 wt %. In an embodiment, % Nb/% Ta is below 0.88 wt %. In another embodiment, the theorical composition of the powder or powder mixture (the sum of the compositions of all the powders contained in the powder mixture) has the following elements and limitations, all percentages being indicated in weight percent: % Fe: 0-42; % Cu: 0-34; % Cr: 0-31; % Mo: 0-24; % Co: 0-18: % W: 0-14; % Nb: 0-5.5; % Mn: 0-5.25; % Al: 0-5; Ti: 0-3: % Zn: 0-1; % Si: 0-1: % C: 0-0.3; % S: 0.01 max: balance nickel (Ni) and trace elements (as previously defined in this document). In an embodiment, % Fe is above 1.64 wt %. In an embodiment, % Fe is above 4.58 wt %. In an embodiment, % Fe is below 26.8 wt %. In an embodiment, % Fe is below 14.42 wt %. In an embodiment, % Cu is above 1.14 wt %. In an embodiment, % Cu is above 2.58 wt %. In an embodiment, % Cu is below 16.8 wt %. In an embodiment, % Cu is below 9.42 wt %. In an embodiment, % Cr is above 0.64 wt %. In an embodiment, % Cr is above 3.58 wt %. In an embodiment, % Cr is below 14.8 wt %. In an embodiment, % Cr is below 6.42 wt %. In an embodiment, % Mo is above 1.12 wt %. In an embodiment, % Mo is above 4.58 wt %. In an embodiment, % Mo is below 12.8 wt %. In an embodiment, % Mo is below 4.42 wt %. In an embodiment, % Co is above 0.12 wt %. In an embodiment, % Co is above 1.58 wt %. In an embodiment, % Co is below 9.8 wt %. In an embodiment, % Co is below 3.42 wt %. In an embodiment, % W is above 0.22 wt %. In an embodiment, % W is above 1.58 wt %. In an embodiment, % W is below 9.8 wt %. In an embodiment, % W is below 4.42 wt %. In an embodiment, % Nb is above 0.002 wt %. In an embodiment, % Nb is above 0.58 wt %. In an embodiment, % Nb is below 3.8 wt %. In an embodiment, % Nb is below 1.42 wt %. In an embodiment, % Al is above 0.002 wt %. In an embodiment, % Al is above 0.28 wt %. In an embodiment, % Al is below 3.4 wt %. In an embodiment, % Al is below 1.42 wt %. In an embodiment, % Ti is above 0.006 wt %. In an embodiment, % Ti is above 0.18 wt %. In an embodiment, % Ti is below 3.8 wt %. In an embodiment, % Ti is below 1.22 wt %. In an embodiment, % Zn is above 0.009 wt %. In an embodiment, % Zn is above 0.08 wt %. In an embodiment, % Zn is below 0.68 wt %. In an embodiment, % Zn is below 0.19 wt %. In an embodiment, % Si is above 0.09 wt %. In an embodiment, % Si is above 0.14 wt %. In an embodiment, % Si is below 0.48 wt %. In an embodiment, % Si is below 0.19 wt %. In an embodiment, % C is above 0.02 wt %. In an embodiment, % C is above 0.09 wt %. In an embodiment, % C is below 0.19 wt %. In an embodiment, % C is below 0.12 wt %. In an embodiment, % S is above 0.0002 wt %. In an embodiment, %/S is above 0.0004 wt %. In an embodiment, % S is below 0.009 wt %. In an embodiment, % S is below 0.0009 wt %. In another embodiment, the theorical composition of the powder or powder mixture (the sum of the compositions of all the powders contained in the powder mixture) has the following elements and limitations, all percentages being indicated in weight percent: % V: 0-14.5: % Mo: 0-13; % Cr: 0-12; % Sn: 0-11.5; % Al: 0-8; % Mn: 0-8; % Zr: 0-7.5: % Cu: 0-3; % Nb: 0-2.5; % Fe: 0-2.5; % Ta: 0-1.5; % Si: 0-0.5; % C: 0.1 max; % N: 0.05 max; % O: 0.2 max; % H: 0.03 max; balance titanium (Ti) and trace elements (as previously defined in this paragraph). In an embodiment, % V is above 0.02 wt %. In an embodiment, % V is above 0.68 wt %. In an embodiment, % V is below 9.8 wt %. In an embodiment, % V is below 4.42 wt %. In an embodiment, % Mo is above 0.36 wt %. In an embodiment, % Mo is above 2.68 wt %. In an embodiment, % Mo is below 8.8 wt %. In an embodiment, % Mo is below 6.42 wt %. In an embodiment, % Cr is above 0.16 wt %. In an embodiment, % Cr is above 3.68 wt %. In an embodiment, % Cr is below 9.8 wt %. In an embodiment, % Cr is below 4.42 wt %. In an embodiment, % Sn is above 0.06 wt %. In an embodiment, % Sn is above 0.62 wt %. In an embodiment, % Sn is below 6.8 wt %. In an embodiment, % Sn is below 2.42 wt %. In an embodiment, % Al is above 0.006 wt %. In an embodiment, % Al is above 0.42 wt %. In an embodiment, % Al is below 4.8 wt %. In an embodiment, % Al is below 2.42 wt %. In an embodiment, % Mn is above 0.02 wt %. In an embodiment, % Mn is above 0.12 wt %. In an embodiment, % Mn is below 6.8 wt %. In an embodiment, % Mn is below 4.42 wt %. In an embodiment, % Zr is above 0.008 wt %. In an embodiment, % Zr is above 0.02 wt %. In an embodiment, % Zr is below 4.8 wt %. In an embodiment, % Zr is below 2.42 wt %. In an embodiment, % Cu is above 0.0008 wt %. In an embodiment, % Cu is above 006 wt %. In an embodiment, % Cu is below 1.8 wt %. In an embodiment, % Cu is below 0.42 wt %. In an embodiment, % Nb is above 0.0009 wt %. In an embodiment, % Nb is above 0.02 wt %. In an embodiment, % Nb is below 0.64 wt %. In an embodiment, % Nb is below 0.42 wt %. In an embodiment, % Fe is above 0.009 wt %. In an embodiment, % Fe is above 0.04 wt/o. In an embodiment, % Fe is below 1.64 wt %. In an embodiment, % Fe is below 0.92 wt %. In an embodiment, % Ta is above 0.0007 wt %. In an embodiment, % Ta is above 0.002 wt %. In an embodiment, % Ta is below 0.44 wt %. In an embodiment, % Ta is below 0.19 wt %. In an embodiment, % Si is above 0.0001 wt %. In an embodiment, % Si is above 0.02 wt %. In an embodiment, % Si is below 0.34 wt %. In an embodiment, % Si is below 0.09 wt %. In an embodiment, % C is above 0.00001 wt %. In an embodiment, % C is above 0.002 wt %. In an embodiment, % C is below 0.03 wt %. In an embodiment, % C is below 0.09 wt %. In an embodiment, % N is above 0.000001 wt %. In an embodiment, % N is above 0.0002 wt %. In an embodiment, % N is below 0.003 wt %. In an embodiment, % N is below 0.008 wt %. In an embodiment, % O is above 0.00002 wt %. In an embodiment, % C is above 0.001 wt %. In an embodiment, % O is below 0.04 wt %. In an embodiment, % O is below 0.09 wt %. In an embodiment, % H is above 0.000001 wt %. In an embodiment, % H is above 0.0002 wt %. In an embodiment, % H is below 0.003 wt %. In an embodiment, % H is below 0.008 wt %. In an embodiment, the theorical composition of the powder or powder mixture (the sum of the compositions of all the powders contained in the powder mixture) has the following elements and limitations, all percentages being indicated in weight percent: % Al: 0-10; % Zn: 0-6; % Y: 0-5.2: % Cu: 0-3; % Ag: 0-2.5, % Th: 0-3.3; Si: 0-1.1; % Mn: 0-0.75; balance magnesium (Mg) and trace elements (as previously defined in this paragraph). In an embodiment, % Al is above 0.2 wt %. In an embodiment, % Al is above 1.68 wt %. In an embodiment, % Al is below 7.8 wt %. In an embodiment, % Al is below 4.42 wt %. In an embodiment, % Zn is above 0.04 wt %. In an embodiment, % Zn is above 0.16 wt %. In an embodiment, % Zn is below 4.8 wt %. In an embodiment, % Zn is below 2.34 wt %. In an embodiment, % Y is above 0.26 wt %. In an embodiment, % Y is above 0.56 wt %. In an embodiment, % Y is below 3.8 wt %. In an embodiment, % Y is below 2.44 wt %. In an embodiment, % Cu is above 0.06 wt %. In an embodiment, % Cu is above 0.12 wt %. In an embodiment, % Cu is below 1.8 wt %. In an embodiment, % Cu is below 1.44 wt %. In an embodiment, % Ag is above 0.008 wt %. In an embodiment, % Ag is above 0.009 wt %. In an embodiment, % Ag is below 0.8 wt %. In an embodiment, % Ag is below 0.44 wt %. In an embodiment, % Th is above 0.006 wt %. In an embodiment, % Th is above 0.02 wt %. In an embodiment, % Th is below 0.84 wt %. In an embodiment, % Th is below 0.44 wt %. In an embodiment, % Si is above 0.06 wt %. In an embodiment, % Si is above 0.2 wt %. In an embodiment, % Si is below 0.44 wt %. In an embodiment, % Si is below 0.24 wt %. In an embodiment, % Mn is above 0.004 wt %. In an embodiment, % Mn is above 0.02 wt %. In an embodiment, % Mn is below 0.44 wt %. In an embodiment, % Mn is below 0.14 wt %. All the embodiments disclosed above can be combined among them in any combination, provided that they are not mutually exclusive.

It has been found that for some applications it is interesting to use the present application for materials where the metal is not the majoritarian element in volume percentage. Some applications requiring very high wear resistance can benefit from mixtures of powders with high concentrations of very abrasion resistant particles. In an embodiment, the powder mixtures of the present invention comprise a high content of abrasion resistant particles. In an embodiment, the high abrasion resistant particles comprise carbides. In an embodiment, the high abrasion resistant particles comprise nitrides. In an embodiment, the high abrasion resistant particles comprise oxides. In an embodiment, the high abrasion resistant particles comprise tungsten carbide. In an embodiment, the high abrasion resistant particles comprise tantalum carbide. In an embodiment, the high abrasion resistant particles comprise molybdenum carbide. In an embodiment, the high abrasion resistant particles comprise niobium carbide. In an embodiment, the high abrasion resistant particles comprise chromium carbide. In an embodiment, the high abrasion resistant particles comprise vanadium carbide. In an embodiment, the high abrasion resistant particles comprise titanium nitride. In an embodiment, the high abrasion resistant particles comprise silicon carbide. In an embodiment, the high abrasion resistant particles comprise boron carbide. In an embodiment, the high abrasion resistant particles comprise diamond. In an embodiment, the high abrasion resistant particles comprise aluminum oxide. In an embodiment, a high concentration of very abrasion resistant particles is 62 vol % or more. In an embodiment, a high concentration of very abrasion resistant particles is 72 vol % or more. In an embodiment, a high concentration of very abrasion resistant particles is 82 vol % or more. In an embodiment, a high concentration of very abrasion resistant particles is 93 vol % or more. In an embodiment, a high concentration of very abrasion resistant particles is 98 vol % or less. In an embodiment, a high concentration of very abrasion resistant particles is 94 vol % or less. In an embodiment, a high concentration of very abrasion resistant particles is 88 vol % or less. In an embodiment, a high concentration of very abrasion resistant particles is 78 vol % or less. In an embodiment, the remainder is one of the metallic alloys described in the present document. In an embodiment, the remainder is a low alloyed metal. In an embodiment, a low alloyed metal is a metal with a large content of a main element. In an embodiment, a large content of a main element is 72 wt % or more. In an embodiment, a large content of a main element is 72 wt % or more. In an embodiment, a large content of a main element is 82 wt % or more. In an embodiment, a large content of a main element is 92 wt % or more. In an embodiment, a large content of a main element is 96 wt % or more. In an embodiment, the main element is cobalt (Co). In an embodiment, the main element is nickel (Ni). In an embodiment, the main element is molybdenum (Mo). In an embodiment, the main element is iron (Fe). In an embodiment, the main element is copper (Cu). In an embodiment, the abrasion resistant particles have a D50 of 15 microns or less. In an embodiment, the abrasion resistant particles have a D50 of 9 microns or less. In an embodiment, the abrasion resistant particles have a D50 of 4.8 microns or less. In an embodiment, the abrasion resistant particles have a D50 of 1.8 microns or less. In an embodiment, the abrasion resistant particles have a D50 of 0.01 microns or more. In an embodiment, the abrasion resistant particles have a D50 of 0.1 microns or more. In an embodiment, the abrasion resistant particles have a D50 of 0.5 microns or more. In an embodiment, the abrasion resistant particles have a D50 of 1.2 microns or more. In an embodiment, the abrasion resistant particles have a D50 of 3.2 microns or more. In an embodiment, D50 refers to a particle size at which 50% of the sample's volume is comprised of smaller particles in the cumulative distribution of particle size. In an alternative embodiment, D50 refers to a particle size at which 50% of the sample's mass is comprised of smaller particles in the cumulative distribution of particle size.

For several applications, including several tooling, it is interesting to have a steel with a high corrosion resistance combined with very high mechanical properties especially in terms of toughness and yield strength. The combination of high yield strength and toughness has always been one of the paradigms of materials science and adding corrosion resistance to the mix makes the whole challenge even more difficult. For such applications always martensitic microstructures are employed (either with carbide strengthening AISI 4XX series or with precipitation strengthening AISI 6XX series), but the inventor has found that for very extreme applications austenitic or at least partially austenitic microstructures might be surprisingly fit for the job and in the process overcoming a general shortage of the martensitic and precipitation hardening stainless steels which is the need to have rather low % Cr contents to attain high levels of yield strength. While the formulations provided for the powder mix might constitute an invention on their own in some instances also the final overall composition might also constitute a standalone invention. For such applications and for the cases when a single powder nature is advantageous or in the case of powders mixtures, taking into account the powder mixture mean composition, the following compositional range (also referred as nitrogen austenitic steel) is preferred, all percentages being indicated in weight percent: % Mo: 0-6.8; % W: 0-6.9; % Moeq: 0-6.8; % Ceq: 0.16-1.8; % C: 0-1.29; % N: 0.11-2.09; % B: 0-0.14; % Si: 0-1.5; % Mn: 0-24; % Ni: 0-18.9; % Cr: 12.1-38; % Ti: 0-2.4;% Al: 0-14; % V: 0-4; % Nb: 0-4; % Zr: 0-3; % Hf: 0-3; % Ta: 0-3; % S: 0-0.098; % P: 0-0.098; % Pb: 0-0.9; % Cu: 0-3.9; % Bi: 0-0.08; % Se: 0-0.08; % Co: 0-14; % REE: 0-4; % Y: 0-1.86; % Sc: 0-0.96; % Cs: 0-1.4; % O: 0.00012-0.899; % Y+% Sc+% REE: 0.0022-3.9%; the rest consisting of iron and trace elements; wherein % Ceq=% C+0.86*% N+½*% B and % Moeq=% Mo+%*% W; and wherein % REE is as previously defined. In an embodiment, trace elements refers to several elements, unless context clearly indicates otherwise, including but not limited to H, He, Xe, F, Ne, Na, Cl, Ar, K, Br, Kr, Sr, Tc. Ru, Rh, Ti, Pd, Ag, I, Ba, Re, Os, Ir, Pt, Au, Hg, Tl, Po, At, Rn, Fr, Ra, Rf, Ob, Sg, Bh, Hs, Li, Be, Mg, Ca, Rb, Zn, Cd, Al, Ga, In, Go, Sn, Sb, As, Te, Ds, Rg, Cn, Nh, Fl, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the presence of % Mo is desirable, while in other applications it is rather an impurity. In different embodiments, % Mo is above 0.16 wt %, above 0.51 wt %, above 1.6 wt %, above 2.1 wt %, above 2.6 wt % and even above 4.1 wt %. For some applications, excessive % Mo seems to deteriorate the mechanical properties. In different embodiments, % Mo is below 5.9 wt %, below 5.4 wt %, below 4.4 wt % and even below 2.9 wt %. Obviously, there are cases where the desired nominal content is Owt % or nominal absence of the element as occurs with all optional elements for certain applications. For some applications, the presence of % W is desirable, while in other applications it is rather an impurity. In different embodiments, % W is above 0.09 wt %, above 0.21 wt %, above 1.1 wt %, above 1.56 wt %, above 2.1 wt % and even above 2.56 wt %. For some applications, excessive % W seems to deteriorate the mechanical properties. In different embodiments, % W is below 5.8 wt %, below 5.2 wt %, below 4.2 wt %, below 2.8 wt % and even below 1.4 wt %. Obviously, there are cases where the desired nominal content is Owt % or nominal absence of the element as occurs with all optional elements for certain applications. For some applications, % Mo can be partially replaced with % W. This replacement takes place in terms of % Moeq. For some applications, the presence of % Moeq is desirable, while in other applications, it is rather an impurity. In different embodiments, % Moeq is above 0.5 wt %, above 1.6 wt %, above 1.8 wt %, above 2.1 wt % and even above 4.1 wt %. On the other hand, for some applications too high levels of % Moeq will lead to situations where required mechanical properties cannot be attainable. In different embodiments, % Moeq is below 6.2 wt %, below 5.7 wt %, below 4.7 wt %, below 3.8 wt %, below 3.4 wt % and even below 2.9 wt %. For some applications, higher % Ceq contents are preferred. In different embodiments, % Ceq is above 0.26 wt %, above 0.51 wt %, above 0.89 wt %, above 1.06 wt % and even above 1.26 wt %. On the other hand, for certain applications, an excessive content of % Ceq may adversely affect the mechanical properties. In different embodiments, % Ceq is below 1.4 wt %, below 1.24 wt %, below 0.94 wt %, below 0.7 wt % and even below 0.47 wt %. For some applications, the presence of % C is desirable, while in other applications it is rather an impurity. In different embodiments, % C is above 0.12 wt %, above 0.26 wt %, above 0.36 wt %, above 0.52 wt %, above 0.72 wt %, above 0.92 wt % and even above 1.06 wt %. For some applications, excessive % C seems to deteriorate the mechanical properties. In different embodiments, % C is below 1.1 wt %, below 0.98 wt %, below 0.64 wt %, below 0.48 wt % and even below 0.01 wt %. Obviously, there are cases where the desired nominal content is Owt % or nominal absence of the element as occurs with all optional elements for certain applications. For some applications, higher % N contents are preferred. In different embodiments, % N is above 0.16 wt %, above 0.21 wt %, above 0.91 wt %, above 1.26 wt % and even above 1.61 wt %. On the other hand, for certain applications, an excessive content of % N may adversely affect the mechanical properties. In different embodiments, % N is below 1.9 wt %, below 1.44 wt %, below 0.9 wt %, below 0.4 wt % and even below 0.24 wt %. The inventor has found that for certain applications, lower levels of % N can be employed, with certain % Mn and % C contents. In an embodiment, % N<0.11 wt %, % Mn>16%-48 wt % and % C>0.4 wt %. In another embodiment, % N<0.0019 wt %, % Mn>21%-39 wt % and % C>0.52 wt %. The inventor has found that for some applications, particularly when % N>0.4, it is important to control the content of (30*% C+% Ni+2*% Mn/3+% Cu/3+20*(% N-0.4)). In different embodiments, 30*% C+% Ni+2*% Mn/3+% Cu/3+20*(% N-0.4) is larger than 7.2, larger than 11.6, larger than 12.2 and even larger than 16. On the other hand, for certain applications, an excessive content may adversely affect the mechanical properties. In different embodiments, 30*% C+% Ni+2*% Mn/3+% Cu/3+20*(% N-0.4) is smaller than 99, smaller than 79, smaller than 64, smaller than 59 and even smaller than 44. For some applications, the presence of % B is desirable, while in other applications it is rather an impurity. In different embodiments. % B is above 0.0002 wt %, above 0.0006 wt %, above 0.006 wt %, above 0.02 wt %, above 0.09 wt % and even above 0.1 wt %. For some applications, excessive % B seems to deteriorate the mechanical properties. In different embodiments, % B is below 0.12 wt %, below 0.09 wt %, below 0.04 wt % and even below 0.009 wt %. Obviously, there are cases where the desired nominal content is Owt % or nominal absence of the element as occurs with all optional elements for certain applications. For some applications, excessive % Si seems to deteriorate the mechanical properties. In different embodiments, % Si is 1.9 wt % or less, below 0.96 wt %, below 0.74 wt %, below 0.48 wt % and even below 0.19 wt %. For some applications, particularly low levels are preferred. In different embodiments, % Si is below 0.09 wt %, below 0.03 wt %, below 0.009 wt % and even below 0.003 wt %. Obviously, there are cases where the desired nominal content is Owt % or nominal absence of the element as occurs with all optional elements for certain applications. For some applications, the presence of % Mn is desirable, while in other applications it is rather an impurity. In different embodiments, % Mn is above 0.2 wt %, above 0.6 wt %, above 2.6 wt %, above 5.1 wt %, above 8.1 wt %, above 10.6 wt % and even above 18.1 wt %. For some applications, excessive % Mn seems to deteriorate the mechanical properties. In different embodiments, % Mn is below 17.9 wt %, below 14 wt %, below 9.4 wt % and even below 6.9 wt %. For certain applications, even lower % Mn contents are preferred. In different embodiments, % Mn is below 4.9 wt %, below 3.9 wt %, below 2.4 wt % and even below 1.4 wt %. Obviously, there are cases where the desired nominal content is Owt % or nominal absence of the element as occurs with all optional elements for certain applications. For some applications, the presence of % Ni is desirable, while in other applications it is rather an impurity. In different embodiments, % Ni is above 0.1 wt %, above 0.6 wt %, above 2.1 wt %, above 3.6 wt %, above 5.1 wt % and even above 10.1 wt %. For some applications, excessive % Ni seems to deteriorate the mechanical properties. In different embodiments, % Ni is below 14 wt %, below 11.9 wt %, below 7.4 wt % and even below 5.9 wt %. For certain applications, even lower % Ni contents are preferred. In different embodiments, % Ni is below 4.9 wt %, below 3.9 wt %, below 2.2 wt % and even below 1.2 wt %. Obviously, there are cases where the desired nominal content is Owt % or nominal absence of the element as occurs with all optional elements for certain applications. For some applications, a certain content of % Ni+% Mn is desirable. In different embodiments, % Ni+% Mn is above 1.2 wt %, above 2.1 wt %, above 3.2 wt % and even above 4.2 wt %. On the other hand, for some applications, excessive % Ni+% Mn seems to deteriorate the mechanical properties. In different embodiments, % Ni+% Mn is below 29 wt %, below 24 wt %, below 19 wt %, below 16 wt % and even below 14 wt %. For some applications, higher levels of % Cr are preferred. In different embodiments, % Cr is above 12.5 wt %, above 15.1 wt %, above 18.6 wt %, above 20.6 wt %, above 26 wt % and even above 30.6 wt %. On the other hand, for certain applications, an excessive content of % Cr may adversely affect the mechanical properties. In different embodiments, % Cr is below 34 wt %, below 29 wt %, below 26 wt %, below 24 wt % and even below 19.6 wt %. For some applications, excessive % Cr seems to deteriorate the mechanical properties and even lower levels are preferred. In different embodiments, % Cr is below 18.4 wt %, below 16.9 wt %, below 16.2 wt %, below 15.4 wt % and even below 14.9 wt %. The inventor has found that for some applications, % Cr and % N can be partially replaced when certain levels of % Mn and % C are present in the composition. In an embodiment, % Cr<9.9 wt % and % Mn>22 wt % and % N<0.4 wt % and % C>0.52 wt %. For some applications, the presence of % Ti is desirable, while in other applications it is rather an impurity. In different embodiments, % Ti is above 0.12 wt %, above 0.51 wt %, above 0.81 wt %, above 1.1 wt %, above 1.6 wt % and even above 1.8 wt %. For some applications, excessive % Ti seems to deteriorate the mechanical properties. In different embodiments, % Ti is below 1.9 wt %, below 1.4 wt %, below 0.9 wt %, below 0.5 wt % and even below 0.14 wt %. Obviously, there are cases where the desired nominal content is 0 wt % or nominal absence of the element as occurs with all optional elements for certain applications. For some applications, the presence of % Al is desirable, while in other applications it is rather an impurity. In different embodiments, % Al is above 0.001 wt %, above 0.16 wt %, above 1.1 wt %, above 2.6 wt %, above 5.1 wt % and even above 10.6 wt %. On the other hand, for certain applications, an excessive content of % Al may adversely affect the mechanical properties. In different embodiments. % Al is below 12 wt %, below 9.4 wt %, below 7.4 wt %, below 5.9 wt % and even below 4.9 wt %. For some applications, lower % Al contents are preferred. In different embodiments. % Al is below 3.4 wt %, below 2.9 wt %, below 2.2 wt %, below 1.5 wt % and even below 0.9 wt %. Obviously, there are cases where the desired nominal content is Owt % or nominal absence of the element as occurs with all optional elements for certain applications. For some applications, excessive % V seems to deteriorate the mechanical properties. In different embodiments, % V is below 2.94 wt %, below 1.48 wt %, below 0.94 wt %, below 0.4 wt % and even below 0.19 wt %. Obviously, there are cases where the desired nominal content is Owt % or nominal absence of the element as occurs with all optional elements for certain applications. For some applications, a certain content of % Al+% Ti+% V is desirable. In different embodiments, % Al+% Ti+% V is above 0.001 wt %, above 0.52 wt % and even above 1.6 wt %. For some applications, excessive % Al+% Ti+% V seems to deteriorate the mechanical properties. In different embodiments, % Al+% Ti+% V is below 5.9 wt %, below 4 wt % and even below 2.4 wt %. For some applications, the presence of % Nb is desirable, while in other applications it is rather an impurity. In different embodiments. % Nb is above 0.06 wt %, above 0.1 wt %, above 0.26 wt %, above 0.6 wt %, above 1.6 wt % and even above 2.1 wt %. On the other hand, for certain applications, an excessive content of % Nb may adversely affect the mechanical properties. In different embodiments, % Nb is below 2.9 wt %, below 1.4 wt %, below 0.9 wt %, below 0.4 wt % and even below 0.1 wt %. Obviously, there are cases where the desired nominal content is Owt % or nominal absence of the element as occurs with all optional elements for certain applications. For some applications, a certain content of % Cr+% Mo+1.5*% Si+0.5*% Nb+5*% V+3*% Al is desirable to improve the mechanical strength related properties. In different embodiments. % Cr+% Mo+1.5*% Si+0.5*% Nb+5*% V+3*% Al is above 11.6 wt % above 13.1 wt % above 16 wt % and even above 21 wt %. On the other hand, for some applications, excessive % Cr+% Mo+1.5*% Si+0.5*% Nb+5*% V+3*% Al can lead to massive deterioration of the toughness. In different embodiments, % Cr+% Mo+1.5*% Si+0.5*% Nb+5*% V+3*% Al is below 99 wt %, below 69 wt %, below 59 wt %, below 49 wt % and even below 34 wt %. For some applications, the presence of % Zr is desirable, while in other applications it is rather an impurity. In different embodiments, % Zr is above 0.09 wt %, above 0.12 wt %, above 0.36 wt %, above 0.6 wt % and even above 1.6 wt %. On the other hand, for some applications, excessive % Zr seems to deteriorate the mechanical properties. In different embodiments, % Zr is below 2.4 wt %, below 1.8 wt %, below 0.9 wt %, below 0.4 wt % and even below 0.08 wt %. Obviously, there are cases where the desired nominal content is Owt % or nominal absence of the element as occurs with all optional elements for certain applications. For some applications, excessive % Hf seems to deteriorate the mechanical properties. In different embodiments, % Hf is below 2.2 wt %, below 1.8 wt %, below 0.9 wt %, below 0.4 wt % and even below 0.08 wt %. Obviously, there are cases where the desired nominal content is Owt % or nominal absence of the element as occurs with all optional elements for certain applications. For some applications, excessive % Ta seems to deteriorate the mechanical properties. In different embodiments, % Ta is below 2.2 wt %, below 1.8 wt %, below 0.9 wt %, below 0.4 wt % and even below 0.08 wt %. Obviously, there are cases where the desired nominal content is Owt % or nominal absence of the element as occurs with all optional elements for certain applications. For some applications, a certain content of % Zr+% Hf+% Ta is desirable. In different embodiments, % Zr+% Hf+% Ta is above 0.001 wt %, above 0.16 wt % and even above 1.26 wt %. On the other hand, for some applications, excessive % Zr+% Hf+% Ta seems to deteriorate the mechanical properties. In different embodiments, % Zr+% Hf+% Ta is below 5.4 wt %, below 4 wt % and even below 2.4 wt %. For some applications, the presence of % Cu is desirable, while in other applications it is rather an impurity. In different embodiments, % Cu is above 0.1 wt %, above 0.29 wt %, above 0.6 wt %, above 1.2 wt % and even above 1.6 wt %. On the other hand, for certain applications, an excessive content of % Cu may adversely affect the mechanical properties. In different embodiments, % Cu is below 2.8 wt %, below 1.9 wt %, below 1.2 wt %, below 0.9 wt % and even below 0.39 wt %. Obviously, there are cases where the desired nominal content is Owt % or nominal absence of the element as occurs with all optional elements for certain applications. For some applications, a certain content of % Ni+% Co+% Cu is desirable. In different embodiments, % Ni+% Co+% Cu is above 1.2 wt %, above 2.1 wt %, above 3.2 wt % and even above 4.2 wt %. On the other hand, for certain applications, an excessive content may adversely affect the mechanical properties. In different embodiments, % Ni+% Co+% Cu is below 24 wt %, below 16 wt %, below 14 wt % and even below 9 wt %. For some applications, excessive % Bi seems to deteriorate the mechanical properties. In different embodiments, % Bi is below 0.05 wt %, below 0.02 wt %, below 0.009 wt %, below 0.005 wt % and even below 0.0009 wt %. Obviously, there are cases where the desired nominal content is Owt % or nominal absence of the element as occurs with all optional elements for certain applications. For some applications, excessive % Se seems to deteriorate the mechanical properties. In different embodiments, % Se is below 0.04 wt %, below 0.01 wt %, below 0.009 wt %, below 0.004 wt % and even below 0.0008 wt %. Obviously, there are cases where the desired nominal content is Owt % or nominal absence of the element as occurs with all optional elements for certain applications. The inventor has found that for some applications, % Se can be at least partially replaced by % Te. For some applications, the presence of % Pb is desirable, while in other applications it is rather an impurity. In different embodiments, % Pb is above 0.001 wt %, above 0.009 wt %, above 0.06 wt %, above 0.1 wt % and even above 0.26 wt %. On the other hand, for certain applications, an excessive content of % Pb may adversely affect the mechanical properties. In different embodiments. % Pb is below 0.6 wt %, below 0.4 wt %, below 0.19 wt %, below 0.09 wt % and even below 0.009 wt %. Obviously, there are cases where the desired nominal content is Owt % or nominal absence of the element as occurs with all optional elements for certain applications. For some applications, a certain content of % Pb+% Bi+% Se is desirable. In different embodiments, % Pb+% Bi+% Se is above 0.0001 wt %, above 0.001 wt % and even above 0.06 wt %. On the other hand, for certain applications, an excessive content may adversely affect the mechanical properties. In different embodiments, % Pb+% Bi+% Se is below 0.44 wt %, below 0.19 wt % and even below 0.15 wt %. For some applications, excessive % P seems to deteriorate the mechanical properties. In different embodiments, % P is below 0.02 wt %, below 0.008 wt %, below 0.005 wt %, below 0.0004 wt % and even below 0.00008 wt %. Obviously, there are cases where the desired nominal content is Owt % or nominal absence of the element as occurs with all optional elements for certain applications. For some applications, a certain content of % Pb+% Bi+% Se+% Cu+% P is desirable. In different embodiments, % Pb+% Bi+% Se+% Cu+% P is above 0.0001 wt %, above 0.09 wt % and even above 0.12 wt %. On the other hand, for certain applications, an excessive content may adversely affect the mechanical properties. In different embodiments, % Pb+% Bi+% Se+% Cu+% P is 0.94 wt %, below 0.4 wt % and even below 0.3 wt %. For some applications, excessive % S seems to deteriorate the mechanical properties. In different embodiments, % S is below 0.04 wt %, below 0.009 wt %, below 0.004 wt %, below 0.0008 wt % and even below 0.00009 wt %. Obviously, there are cases where the desired nominal content is Owt % or nominal absence of the element as occurs with all optional elements for certain applications. For some applications, a certain content of % P+% S is desirable. In different embodiments, % P+% S is above 0.0001 wt %, above 0.001 wt % and even above 0.009 wt %. On the other hand, for certain applications, an excessive content may adversely affect the mechanical properties. In different embodiments, % P+% S is 0.1 wt %, below 0.04 wt % and even below 0.015 wt %. For some applications, the presence of % Co is desirable, while in other applications it is rather an impurity. In different embodiments, % Co is above 0.1 wt %, above 0.6 wt %, above 2.1 wt %, above 4.1 wt %, above 5.6 wt % and even above 10.6 wt %. On the other hand, for some applications, excessive % Co seems to deteriorate the mechanical properties. In different embodiments, % Co is below 11.4 wt %, below 9.9 wt %, below 4.9 wt %, below 3.4 wt % and even below 2.9 wt %. For some applications, lower % Co contents are preferred. In different embodiments, % Co is below 2.4 wt %, below 1.9 wt %, below 1.2 wt %, below 0.8 wt % and even below 0.38 wt %. Obviously, there are cases where the desired nominal content is Owt % or nominal absence of the element as occurs with all optional elements for certain applications. For some applications, a certain content of % Ni+% Co+% Cu+% Mn is desirable to improve the mechanical properties. In different embodiments, % Ni+% Co+% Cu+% Mn is above 1.2 wt %, above 2.1 wt %, above 3.2 wt % and even above 4.2 wt %. On the other hand, for certain applications, excessive % Ni+% Co+% Cu+% Mn may adversely affect the mechanical properties. In different embodiments, % Ni+% Co+% Cu+% Mn is below 29 wt %, below 24 wt %, below 19 wt %, below 16 wt % and even below 14 wt %. For some applications, the presence of % Y is desirable, while in other applications it is rather an impurity. In different embodiments, % Y is above 0.009 wt %, above 0.02 wt %, above 0.16 wt %, above 0.26 wt %, above 0.6 wt % and even above 1.26 wt %. On the other hand, for some applications, excessive % Y seems to deteriorate the mechanical properties. In different embodiments, % Y is below 1.4 wt %, below 1.2 wt %, below 0.8 wt %, below 0.2 wt % and even below 0.09 wt %. Obviously, there are cases where the desired nominal content is Owt % or nominal absence of the element as occurs with all optional elements for certain applications. For some applications, the presence of % Sc is desirable, while in other applications it is rather an impurity. In different embodiments, % Sc is above 0.001 wt %, above 0.04 wt %, above 0.12 wt %, above 0.21 wt % and even above 0.6 wt %. On the other hand, for some applications, excessive % Sc seems to deteriorate the mechanical properties. In different embodiments, % Sc is below 0.74 wt %, below 0.4 wt %, below 0.18 wt %, below 0.02 wt % and even below 0.04 wt %. Obviously, there are cases where the desired nominal content is Owt % or nominal absence of the element as occurs with all optional elements for certain applications. For some applications, excessive % Cs seems to deteriorate the mechanical properties. In different embodiments, % Cs is below 0.94 wt %, below 0.44 wt %, below 0.19 wt %, below 0.09 wt % and even below 0.004 wt %. Obviously, there are cases where the desired nominal content is Owt % or nominal absence of the element as occurs with all optional elements for certain applications. For some applications, higher % O contents are preferred. In different embodiments, % O is above 0.006 wt %, above 0.01 wt %, above 0.09 wt %, above 0.26 wt % and even above 0.41 wt %. On the other hand, for certain applications, an excessive content of % O may adversely affect the mechanical properties. In different embodiments, % O is below 0.49 wt %, below 0.24 wt %, below 0.09 wt %, below 0.04 wt % and even below 0.0024 wt %. For some applications, the presence of % REE (as previously defined) is desirable, while in other applications it is rather an impurity. In different embodiments, % REE is above 0.09 wt %, above 0.16 wt %, above 0.21 wt %, above 1.1 wt % and even above 1.6 wt %. On the other hand, for certain applications, excessive % REE may adversely affect the mechanical properties. In different embodiments, % REE is below 2.9 wt %, below 1.4 wt %, below 0.9 wt %, below 0.4 wt %, below 0.2 wt % and even below 0.09 wt %. Obviously, there are cases where the desired nominal content is Owt % or nominal absence as occurs with all optional elements for certain applications. For some applications, a certain content of % Sc+% Y+% REE is desirable. In different embodiments, % Y+% Sc+% REE is above 0.21 wt %, above 0.56 wt %, above 1.26 wt %, above 2.1 wt % and even above 2.56 wt %. For some applications, excessive % Y+% Sc+% REE seems to deteriorate the mechanical properties. In different embodiments, % Y+% Sc+% REE is below 2.9 wt %, below 1.9 wt %, below 1.4 wt % and even below 0.4 wt %. In some particular applications, even lower levels of % Y+% Sc+% REE are preferred. In an embodiment, % Y4% Sc+% REE<0.0022 wt %. In addition, it should be noted that everywhere in the document<includes the case where the element is not present. In some embodiments, the above disclosed for the content of % O, % Cs, % Y, % Sc, % REE and/or % Ti can also be applied to this composition. For some applications, the relation between the atomic content of % O and % Y+% Sc or alternatively % Y or alternatively % Y+% Sc+% REE has to be controlled for optimum mechanical properties according to the formulas previously disclosed. For some applications, it has been found that it is important to control the following parameter PARD-1=(% Ni+% Mn)/(% Y+% Sc+% REE). In different embodiments, PARD-1 is larger than 0.6, larger than 2, larger than 6, larger than 13, larger than 22, larger than 52, larger than 102 and even larger than 502. For some applications, PARD-1 is preferred below a certain value. In different embodiments. PARD-1 is smaller than 4900, smaller than 2900, smaller than 1998, smaller than 1490, smaller than 990 and even smaller than 590. In the cases where PARD-1 is important, this parameter can take very large values when % Y, % Sc and % REE are not present or present in very small quantities and those values are out of the preferred range for PARD-1 disclosed above—For example a material comprising % Ni=8.1 wt %; % Mn=6.7 wt %; and with no % Y, % Sc or % REE present, which means a PARD-1=(8.1+6.7)/0 that is clearly out of the preferred range PARD-1. The same applies for any other parameter in this document comprising a division in their definition and where the denominator of the division might be a very small value or even zero. For some applications, it has been found that it is important to control the following parameter PARD-2=(% Ni+% Mn)/% N. In different embodiments, PARD-2 is larger than 1.2, larger than 2.6, larger than 4.1, larger than 5.2, larger than 6.2 and even larger than 8.2. For some applications, PARD-2 is preferred below a certain value. In different embodiments, PARD-2 is smaller than 199, smaller than 99, smaller than 49, smaller than 39, smaller than 24 and even smaller than 19. For some applications, it has been found that it is important to control the following parameter PARD-3=% Cr/% N. In different embodiments, PARD-3 is larger than 2.1, larger than 5.2, larger than 8.6, larger than 12.5, larger than 16.2 and even larger than 20.2. For some applications, PARD-3 is preferred below a certain value. In different embodiments, PARD-3 is smaller than 249, smaller than 149, smaller than 99, smaller than 89, smaller than 74, smaller than 64 and even smaller than 48. For some applications, it has been found that it is important to control the following parameter PARD-4=% Cr/(% Y+% Sc+% REE). In different embodiments, PARD-4 is larger than 0.2, larger than 1.2, larger than 3.1, larger than 3.3, larger than 4.1, larger than 22, larger than 41 and even larger than 56. For some applications, PARD-4 is preferred below a certain value. In different embodiments, PARD-4 is smaller than 7900, smaller than 4900, smaller than 2990, smaller than 1400 and even smaller than 990. For some applications, it has been found that it is important to control the following parameter PARD-5=(% Ni+% Mn)/(% N+% Y+% Sc+% REE). In different embodiments, PARD-5 is larger than 0.1, larger than 0.6, larger than 0.9, larger than 1.2, larger than 2.2, larger than 3.2 and even larger than 5.2. For some applications, PARD-5 is preferred below a certain value. In different embodiments, PARD-5 is smaller than 199, smaller than 99, smaller than 74, smaller than 59, smaller than 49, smaller than 38 and even smaller than 24. For some applications, it has been found that it is important to control the following parameter PARD-6=% Cr/(% N+% Y+% Sc+% REE). In different embodiments, PARD-6 is larger than 0.7, larger than 1.2, larger than 2.6, larger than 3.6, larger than 9.6, larger than 12 and even larger than 16. For some applications, PARD-6 is preferred below a certain value. In different embodiments, PARD-6 is smaller than 199, smaller than 99, smaller than 74, smaller than 59, smaller than 49, smaller than 38 and even smaller than 24. For some applications, it has been found that it is important to control the following parameter PARD-7=ABS (% Cr/% N−(% Ni+% Mn)/(% Y+% Sc+% REE)). In different embodiments, PARD-7 is larger than 2, larger than 4.6, larger than 7.6, larger than 10.5, larger than 12 and even larger than 18. For some applications, PARD-7 is preferred below a certain value. In different embodiments, PARD-7 is smaller than 199, smaller than 99, smaller than 74, smaller than 59, smaller than 49, smaller than 38 and even smaller than 24. In an embodiment, oxidation is promoled to stabilize the oxygen at a certain level combined with certain alloying elements. In an embodiment, the oxidation is performed by means of an atmosphere comprising oxygen. In an embodiment, the oxidation is performed by means of an atmosphere containing a controlled oxygen partial pressure. In an embodiment, the oxidation is performed at least partially by means of migration from iron oxide to one or more of the following elements: % Ti, % Sc, % Y. % V, % REE (being % REE as previously defined)—that means that iron oxide gets partially reduced, the content of iron oxide in the material decreases, while either titanium oxide, scandium oxide, yttrium oxide, vanadium oxide or the oxide of one other rare earth increases —. In an embodiment, the oxidation is performed at least partially by means of migration from iron oxide to one or more of the following elements: % Ti, % Sc, % Y. In an embodiment, the oxidation is performed at least partially by means of migration from iron oxide to one or more of the following elements: % Sc, % Y. In an embodiment, the oxidation is performed at least partially by means of migration from chromium oxide to one or more of the following elements: % Ti, % Sc, % Y. % V, % REE (being % REE as previously defined). In an embodiment, the oxidation is performed at least partially by means of migration from chromium oxide to one or more of the following elements: % Ti, % Sc, % Y. In an embodiment, the oxidation is performed at least partially by means of migration from chromium oxide to one or more of the following elements: % Sc, % Y. In an embodiment, large amounts of % REE (as previously defined) are employed and oxidation is promoled. In an embodiment, % O*OC1>% Y+% Sc+% REE>% O*OC2. In different embodiments, OC1 is 0.2, 1.2, 2.1, 3.1, 3.2, 3.4 and even 3.6. In different embodiments, OC2 is 3.8, 3.9, 4.3, 5.3, 6.9, 9.8 and even 14. All the upper and lower limits disclosed in the different embodiments can be combined among them in any combination, provided that they are not mutually exclusive. In an embodiment, an oxidation of at least some of the powder surface is promoled, followed by a compacting and an in situ-reduction of the surface oxides while gettering the oxygen within the powder grains. While the addition of oxides by means of mechanical alloying has proved considerably detrimental for most applications, a reduced number of applications can cope with this procedure. In an embodiment, oxides are introduced in the material powder mixture. In an embodiment, oxides are introduced in the material powder mixture and mechanically alloyed. For some applications, the inventor has found that the presence of austenite in the microstructure of the steel can be advantageous. In an embodiment, the steels obtained using the single powder or powder mixture disclosed above present a microstructure comprising austenite. In different embodiments, the percentage of austenite in the microstructure is at least 42%, at least 52%, at least 76% austenite, at least 82%, at least 94% and even at least 99.2%. In an embodiment, the percentages of austenite disclosed above are by volume (vol %). All the embodiments disclosed above can be combined among them in any combination, provided that they are not mutually exclusive.

For applications with high thermo-mechanical loading benefiting from an aggressive conformal cooling strategy with close to the working surface cooling channels, as well as applications where corrosion resistance has to be combined with mechanical strength and/or fracture toughness, an iron based alloy with high toughness, corrosion resistance and simultaneously exceptional wear resistance, can be achieved with a material with an overall composition as follows, all percentages being indicated in weight percent (wt %):

| | | | |
|---|---|---|---|
| % Cr: 10-14; | % Ni: 5.6-12.5; | % Ti: 0.4-2.8; | % Mo: 0-4.4; |
| % B: 0-4; | % Co: 0-12; | % Mn: 0-2; | % Cu: 0-2; |
| % Al: 0-1; | % Nb: 0-0.5; | % Ce: 0-0.3; | % Si: 0-2; |

% C, % N, % P, % S, % O each 0.09% max.
% C + % N + % P + % S + % O: 0-0.3.
% La + % Cs + % Nd + % Gd + % Pr + % Ac + % Th + % Tb +
% Dy + % Ho + % Er + % Tm + % Yb + % Y + % Lu +
% Sc + % Zr + % Hf: 0-0.4;
% V + % Ta + % W: 0-0.8;

the rest consisting of iron and trace elements.

In an embodiment, trace elements refers to several elements, including, but not limited to: H, He, Xe, F, No, Na, Cl, Ar, K, Br, Kr, Sr, Tc, Ru, Rh, Pd, Ag, I, Ba, Re, Os, Ir, Pt, Au, Hg, Tl, Po, At, Rn, Fr, Ra, Ac, Pa, U, Np, Pu, Am, Cm, Bk, Cf, Es, Fm, Md, No, tr, Rf, Db, Sg, Bh, Hs, Li, Be, Mg, Ca, Rb, Zn, Cd, Ga, In, Go, Sn, Pb, Bi, Sb, As, Se, Te, Th, Ds, Rg, Cn, Nh, Fl, Mc, Lv, Ts, Og, Ta, Sm, Pm, Ho, Eu, and Mt. In an embodiment, trace elements comprise at least one of the elements listed above. Trace elements may be added intentionally to attain a particular functionality to the steel, such as reducing the cost of production and/or its presence may be unintentional and related mostly to the presence of impurities in the alloying elements and scraps used for the production of the steel. In different embodiments, the sum of all trace elements is less than 1.9 wt %, less than 0.4 wt %, less than 0.9 wt % and even less than 0.09 wt %. In different embodiments, each trace element individually is less than 1.9 wt %, less than 0.4 wt %, less than 0.9 wt % and even less than 0.09 wt %. On the other hand, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For some applications, the chromium content is very critical. Too much % Cr can lead to low fracture toughness and too low % Cr to poor corrosion resistance. For some applications, the effect of % Cr on stress corrosion cracking is also pronounced but in intercorrelation with other alloying elements. In different embodiments, % Cr is 10.6 wt % or higher, 11.2 wt % or higher, 11.6 wt % or higher, 12.1 wt % or higher, 12.6 wt % or higher and even 13.2 wt % or higher. In different embodiments, % Cr is 13.4 wt % or lower, 12.9 wt % or lower, 12.4 wt % or lower and even 11.9 wt % or lower. For some applications, the boron content is very critical. Too much % B can lead to low fracture toughness and too low % B to poor wear resistance. For some applications, the effect of % B on high temperature yielding is also pronounced but in intercorrelation with other alloying elements. In different embodiments, % Bis 35 ppm or higher, 120 ppm or higher, 0.02 wt % or higher, 0.12 wt % or higher, 0.6 wt % or higher and even 1.2 wt % or higher. In different embodiments, % B is 1.9 wt % or lower, 0.9 wt % or lower, 0.4 wt % or lower and even 0.09 wt % or lower. For some applications, the titanium content is very critical. Too much % Ti can lead to low fracture toughness and too low % Ti to poor yield strength. For some applications, the effect of % Ti on wear resistance is also pronounced but in intercorrelation with other alloying elements. In different embodiments, % Ti is 0.7 wt % or higher, 1.6 wt % or higher, 1.8 wt % or higher, 2.1 wt % or higher and even 2.55 wt % or higher. In different embodiments. % Ti is 2.4 wt % or lower, 1.9 wt % or lower, 1.4 wt % or lower and even 0.9 wt % or lower. For some applications, the nickel content is very critical. Too much % Ni can lead to low yield strength and too low % Ni to poor elongation at fracture. For some applications, the effect of % Ni on stress corrosion cracking is also pronounced but in intercorrelation with other alloying elements. In different embodiments, % Ni is 6.1 wt % or higher, 7.1 wt % or higher, 8.6 wt % or higher, 10.6 wt % or higher, 11.1 wt % or higher and even 11.5 wt % or higher. In different embodiments, % Ni is 11.9 wt % or lower, 11.4 wt % or lower, 10.9 wt % or lower and even 9.9 wt % or lower. For some applications, the molybdenum content is very critical. Too much % Mo can lead to low fracture toughness and too low % Mo to poor yield strength. For some applications, the effect of % Mo on stress corrosion cracking is also pronounced but in intercorrelation with other alloying elements. In different embodiments, % Mo is 0.26 wt % or higher, 0.76 wt % or higher, 1.2 wt % or higher, 1.6 wt % or higher, 2.1 wt % or higher and even 3.2 wt % or higher. In different embodiments, % Mo is 3.9 wt % or lower, 2.9 wt % or lower, 1.9 wt % or lower and even 0.9 wt % or lower. In another embodiment, % Mo is not intentionally present or present as a trace element only. In another embodiment, % Mo is not present. For some applications, the cobalt content is very critical. Too much % Co can lead to low yield strength and too low % Co to poor corrosion resistance/fracture toughness combination. For some applications, the effect of % Co on stress corrosion cracking is also pronounced but in intercorrelation with other alloying elements. In different embodiments, % Co is 0.6 wt % or higher, 2.2 wt % or higher, 3.6 wt % or higher, 6.1 wt % or higher, 7.6 wt % or higher and even 10.2 wt % or higher. In different embodiments, % Co is 9.9 wt % or lower, 8.9 wt % or lower, 7.9 wt % or lower and even 3.9 wt % or lower. In another embodiment, % Co is not intentionally present or present as a trace element only. In another embodiment, % Co is not present. For some applications, manganese can be added. While a bit of % Mn can improve certain mechanical properties too much % Mn can lead to deterioration of mechanical properties. In different embodiments, % Mn is 0.12 wt % or higher, 0.31 wt % or higher, 0.52 wt % or higher, 0.61 wt % or higher, 0.76 wt % or higher and even 1.2 wt % or higher. In different embodiments, % Mn is 1.4 wt % or lower, 0.9 wt % or lower, 0.29 wt % or lower and even 0.09 wt % or lower. In another embodiment, % Mn is not intentionally present or present as a trace element only. In another embodiment, % Mn is not present. For some applications, copper can be added. While a bit of % Cu can improve yield strength, too much % Cu can lead to deterioration of mechanical properties. In different embodiments, % Cu is 0.12 wt % or higher, 0.31 wt % or higher, 0.52 wt % or higher, 0.61 wt % or higher, 0.76 wt % or higher and even 1.2 wt % or higher. In different embodiments, % Cu is 1.4 wt % or lower, 0.9 wt % or lower, 0.29 wt % or lower and even 0.09 wt % or lower. In another embodiment, % Cu is not intentionally present or present as a trace element only. In another embodiment, % Cu is not present. For some applications, silicon can be added. While a bit of % Si can improve certain mechanical properties too much % Si can lead to deterioration of mechanical properties. In different embodiments, % Si is 0.12 wt % or higher, 0.31 wt % or higher, 0.52 wt % or higher, 0.61 wt % or higher, 0.76 wt % or higher and even 1.2 wt % or higher. In different embodiments, % Si is 1.4 wt % or lower, 0.9 wt % or lower, 0.29 wt % or lower and even 0.09 wt % or lower. In another embodiment, % Si is not intentionally present or present as a trace element only. In another embodiment, % Si is not present. For some applications, aluminum can be added. While a bit of % Al can improve the yield strength too much % Al can lead to deterioration of fracture toughness. In different embodiments, % Al is 0.01 wt % or higher, 0.06 wt % or higher, 0.12 wt % or higher, 0.22 wt % or higher, 0.31 wt % or higher and even 0.51 wt % or higher. In different embodiments, % Al is 0.4 wt % or lower, 0.24 wt % or lower, 0.09 wt % or lower and even 0.04 wt % or lower. In another embodiment, % Al is not intentionally present or present as a trace element only. In another embodiment, % Al is not present. For some applications niobium can be added. While a bit of % Nb can improve the yield strength too much % Nb can lead to deterioration of fracture toughness. In different embodiments, % Nb is 0.01 wt % or higher, 0.04 wt % or higher, 0.06 wt % or higher, 0.12 wt % or higher, 0.22 wt % or higher and even 0.31 wt % or higher. In different embodiment, % Nb is 0.29 wt % or lower, 0.14 wt % or lower, 0.09 wt % or lower and even 0.04 wt % or lower. In another embodiment, % Nb is not intentionally present or present as a trace element only. In another embodiment, % Nb is not present. For some applications cerium can be added. While a bit of % Ce can improve the toughness related properties by lowering the content of some harmful oxides, too much % Ce can lead to exactly the contrary. In different embodiments, % Ce is 0.01 wt % or higher, 0.0006 wt % or higher, 0.001 wt % or higher, 0.006 wt % or higher, 0.01 wt % or higher and even 0.12 wt % or higher. In different embodiments, % Ce is 0.09 wt % or lower, 0.04 wt % or lower, 0.009 wt % or lower, 0.004 wt % or lower and even 0.0009 wt % or lower. In another embodiment, % Ce is not intentionally present or present as a trace element only. In another embodiment, % Ce is not present. For some applications, a certain content of the sum % La+% Cs+% Nd+% Gd+% Pr+% Ac+% Th+% Tb+% Dy+% Ho+% Er+% Tm+% Yb+% Y+% Lu+% Sc+% Zr+% Hf may be advantageous. While a bit of the sum of % La+% Cs+% Nd+% Gd+% Pr+% Ac+% Th+% Tb+% Dy+% Ho+% Er+% Tm+% Yb+% Y+% Lu+% Sc+% Zr+% Hf can improve the toughness related properties by lowering the content of some harmful oxides, too much the sum of % La+% Cs+% Nd+% Gd+% Pr+% Ac+% Th+% Tb+% Dy+% Ho+% Er+% Tm+/% Yb+% Y+% Lu+% Sc+% Zr+% Hf can lead to exactly the contrary. In different embodiments, the sum of % La+% Cs+% Nd+% Gd+% Pr+% Ac+% Th+% Tb+% Dy+% Ho+% Er+% Tm+% Yb+% Y+% Lu+% Sc+% Zr+% Hf is 0.01 wt % or higher, 0.0006 wt % or higher, 0.001% or higher, 0.006 wt % or higher, 0.01 wt % or higher and even 0.12 wt % or higher. In different embodiments, the sum of % La+% Cs+% Nd+% Gd+% Pr+% Ac+% Th+% Tb+% Dy+% Ho+% Er+% Tm+% Yb+% Y+% Lu+% Sc+% Zr+% Hf is 0.09 wt % or lower, 0.04% or lower, 0.009 wt % or lower, 0.004 wt % or lower and even 0.0009 wt % or lower. In another embodiment, the sum of % La+% Cs+% Nd+% Gd+% Pr+% Ac+% Th+% Tb+% Dy+% Ho+% Er+% Tm+% Yb+% Y+% Lu+% Sc+% Zr+% Hf is not intentionally present or present as a trace element only. In another embodiment, the sum of % La+% Cs+% Nd+% Gd+% Pr+% Ac+% Th+% Tb+% Dy+% Ho+% Er+% Tm+% Yb+% Y+% Lu+% Sc+% Zr+% Hf is not present. For some applications, the elements % C, % N, % P, % S, % O are very detrimental and should be kept as low as possible. In different embodiments, at least one of % C, % N, % P, % S, % O is 0.04 wt % or lower, 0.009 wt % or lower, 0.004 wt % or lower, 0.0019 wt % or lower, 0.0009 wt % or lower and even 0.0004 wt % or lower. In another embodiment, at least one of % C, % N, % P, % S, % O is not intentionally present or present as a trace element only. In another embodiment, at least one of % C, % N, % P, % S, % O is not present. In an embodiment, % C is not present in the composition. In another embodiment, % C is a trace element. In an embodiment, % O is not present in the composition. In another embodiment, % O is a trace element. In an embodiment, % N is not present in the composition. In another embodiment, % N is a trace element. In an embodiment, % P is not present in the composition. In another embodiment, % P is a trace element. In an embodiment, % S is not present in the composition. In another embodiment, % S is a trace element. For some applications, the elements % C, % N, % P, % S, % O are very detrimental and should be kept as low as possible. In different embodiments, each of % C, % N, % P, % S, % O is 0.04 wt % or lower, 0.009 wt % or lower, 0.004 wt % or lower, 0.0019 wt % or lower, 0.0009 wt % or lower and even 0.0004 wt % or lower. In another embodiment, each of % C, % N, % P, % S, % O is not intentionally present or present as a trace element only. In another embodiment, each of % C, % N, % P, % S, % O is not present. For some applications, the sum % C+% N+% P+% S+% O can be intentionally added. While a bit of the sum of % C+% N+% P+% S+% O can improve the mechanical strength related properties, too much the sum of % C+% N+% P+% S+% O can lead to massive deterioration of the fracture toughness. In different embodiments, the sum of % C+% N+% P+% S+% O is 0.0006 wt % or higher, 0.001 wt % or higher, 0.006 wt % or higher, 0.01 wt % or higher and even 0.12 wt % or higher. In different embodiments, the sum of % C+% N+% P+% S+% O is 0.09 wt % or lower, 0.04 wt % or lower, 0.009 wt % or lower, 0.004 wt % or lower and even 0.0009 wt % or lower. In another embodiment, the sum of % C+% N+% P+% S+% O is not intentionally present or present as a trace element only. In an embodiment, the sum of % C+% N+% P+% S+% O is not present. For some applications, a certain content of the sum of % V+% Ta+% W may be advantageous. While a bit of the sum of % V+% Ta+% W can improve the wear resistance related properties, too much the sum of % V+% Ta+% W can lead to deterioration of the toughness related properties. In different embodiment, the sum of % V+% Ta+% W is 0.06 wt % or higher, 0.12 wt % or higher, 0.32 wt % or higher, 0.42 wt % or higher and even 0.52 wt % or higher. In different embodiments, the sum of % V+% Ta+% W is 0.49 wt % or lower, 0.24 wt % or lower, 0.14 wt % or lower, 0.09 wt % or lower and even 0.009 wt % or lower. In another embodiment, the sum of % V+% Ta+% W is not intentionally present or present as a trace element only. In another embodiment, the sum of % V+% Ta+% W is not present. In an embodiment, % V is not present in the composition. In an embodiment, % V is a trace element. In an embodiment, % Ta is not present in the composition. In an embodiment, % Ta is a trace element. In an embodiment, % W is not present in the composition. In an embodiment, % W is a trace element.

In an embodiment, the material is solution annealed by heating to a temperature of 980° C.±TOL holding for enough time and quenching. In different embodiments, TOL are 5° C., 10° C., 15° C., 25° C. and even 35° C. In different embodiments, enough time is 10 minutes or more, 30 minutes or more, a1 hour or more, 2 hours or more and even 4 hours or more. In an embodiment, the material is subzero treated after quenching at a low enough temperature for long enough time. In different embodiments, a low enough temperature is −25° C. or less, −50° C. or less, −75° C. or less and even −100° C. or less. In different embodiments, a long enough time is 10 minutes or more, 1 hour or more, 4 hours or more, 8 hours or more and even 16 hours or more. In an embodiment, the material is age hardened by holding it at the right temperature for the appropriate time and then cooling. In different embodiments, the right temperature is 480° C.±TOL, 510° C.±TOL, 540° C. TOL, 590° C.±TOL and even 620° C.±TOL. In different embodiments, TOL are 2° C., 5° C., 7° C. and even 12° C. In different embodiments, the appropriate time is 1 hour or more, 2 hours or more, 4 hours or more, 6 hours or more and even 8 hours or more. For some applications excessive aging time is not recommendable. In different embodiments, the appropriate time is 12 hours or less, 10 hours or less, 8 hours or less and even 6 hours or less. In different embodiments, the material is cold worked with 22% reduction or more, with 31% reduction or more and even with 71% reduction or more previous to the aging treatment previously described. In an embodiment, the material is the manufactured component. In an embodiment, the material is the component manufactured with any of the methods disclosed throughout this document.

In an embodiment, the material described above is locally segregated as a result of having manufactured through a mixture of powders of different composition with carefully chosen composition and size and intentionally not having allowed enough time for full homogenization. This which would normally be considered a defect on the material has surprisingly given a higher performance material in some applications, in particular those involving counterparts with big abrasive particles. In an embodiment, there is relevant segregation in large enough areas of significant elements. In different embodiments, for segregation to be relevant when dividing the weight percentage of the rich area in the significant element through the weight percentage of the poor area in the significant element a value exceeding 1.06, exceeding 1.12, exceeding 1.26, exceeding 1.56, exceeding and even exceeding 2.12 is obtained. In different embodiments, a large enough area is any area exceeding 26 square microns, exceeding 56 square microns, exceeding 86 square microns, exceeding 126 square microns and even exceeding 260 square microns. In an embodiment, a significant element is % Cr. In an embodiment, a significant element is % Ni. In an embodiment, a significant element is % Ti. In an embodiment, a significant element is % Co. In an embodiment, a significant element is % Mo. Obviously, some applications benefit from not having relevant segregation in the material. In different embodiments, a rich area in a significant element is an area wherein the element is at least 2.3 wt % or more, at least 5.3 wt % or more and even 10.4 wt % or more. In different embodiments, a poor area in a significant element is an area wherein the significant element is 1.29 wt % or less, 0.59 wt % or less and even 0.29 wt % or less.

In an embodiment, any material described in this document is locally segregated as a result of having manufactured through a mixture of powders of different composition with carefully chosen composition and size and intentionally not having allowed enough time for full homogenization. This which would normally be considered a defect on the material has surprisingly given a higher performance material in some applications. In an embodiment, there is relevant segregation in large enough areas of significant elements. In different embodiments, for segregation to be relevant when dividing the weight percentage of the rich area in the significant element through the weight percentage of the poor are in the significant element a value exceeding 1.06, exceeding 1.12, exceeding 1.26, exceeding 1.56 and even exceeding 2.12 is obtained. In different embodiments, a large enough area is any area exceeding 26 square microns. In another embodiment, a large enough area is any area exceeding 56 square microns, exceeding 86 square microns, exceeding 126 square microns and even exceeding 260 square microns. In different embodiments, a significant element is an element chosen from all the elements present in an amount of 0.3 wt % or more, of 0.6 wt % or more, of 1.3 wt % or more, of 2.3 wt % or more, of 5.3 wt % or more and even of 10.3 wt % or more. Obviously, some applications benefit from not having relevant segregation in the material.

In this entire document when the values or a range of a composition for an element start at 0 [example: % Ti: 0-3.4], or the content of the element is expressed as smaller than a certain value “<” [example: % C<0.29] in both cases the number 0 is to be expected in some embodiments. In some embodiments, it is a nominal “0” that means the element might just be present as an undesirable trace element or impurity. In some embodiments, the element might also be absent. This arises another important aspect, since many documents in the literature, unaware of the technical effect of having a particular element under a certain critical threshold, mention that element as potentially “0” or “<” but the real content is either not measured, because of the unawareness of its technical effect when present in specially low levels, or always at rather high values when measured (difference of nominal “0” and absence, or critical threshold values for doping elements having a technical effect when present at low levels).

In all the embodiments of this document, where a particular definition is employed for terminology, there is an additional embodiment, which is identical but uses the literature definition of the terminology (this is referred here and not in every terminology definition for the sake of extension).

The powders and powder mixtures disclosed in preceding paragraphs can be advantageously used in the methods disclosed throughout this document. Accordingly, all the embodiments disclosed above can be combined with any of the methods disclosed throughout this document in any combination, provided that they are not mutually exclusive.

The aspect of the invention disclosed in the following paragraph is applicable to the powders or powder mixtures disclosed throughout in this document but can also be applied to other powders or powder mixtures and thus might constitute an invention on their own.

The inventor has found that for some applications, it is advantageous to depart from a very low oxygen content powder or powder mixture. This is especially the case when using some of the instances of the present invention that achieve very low porosity right after applying a pressure and/or temperature treatment (as described later in this document). The inventor has found that in such instances achieving high final mechanical properties, especially in terms of toughness related properties is strongly related to the oxygen level and sometimes also nitrogen level of the powder or powder mixture. These findings were a result of the inventor trying to reduce the oxygen level content of powders in a system employing microwaves as the main power source for heating of the powder contained in a properly designed atmosphere. Unless otherwise stated, the feature “properly designed atmosphere” is defined throughout the present document in the form of different alternatives that are explained in detail below. For some applications, a vacuum atmosphere is advantageous. In an embodiment, the method comprises employing microwaves to reduce the oxygen and/or nitrogen level of a powder or powder mixture. In an embodiment, the method comprises the use of a properly designed atmosphere. In an embodiment, a properly designed atmosphere means a vacuum atmosphere. In different embodiments, a properly designed atmosphere means a vacuum level of 590 mbar or better, of 99 mbar or better, of 9 mbar or better, of 0.9 mbar or better, of 0.9*10⁻² mbar or better, of 0.9*10⁻³ mbar or better, of 0.9*10⁻⁴ mbar or better and even of 0.9*10⁻⁵ mbar or better. For some applications, an excessively low vacuum is not helpful. In different embodiments, a properly designed atmosphere means a vacuum level of 1.2*10⁻¹⁰ mbar or worse, of 1.2*10⁻⁸ mbar or worse, of 1.2*10⁻⁶ mbar or worse and even of 1.2*10⁻⁴ mbar or worse. In an embodiment, a properly designed atmosphere means an atmosphere comprising a noble gas. In an embodiment, a properly designed atmosphere means an atmosphere comprising mostly noble gases. In an embodiment, a properly designed atmosphere means an atmosphere comprising % Ar. In an embodiment, a properly designed atmosphere means an atmosphere comprising mostly % Ar. In an embodiment, a properly designed atmosphere means an atmosphere comprising % He. In an embodiment, a properly designed atmosphere means an atmosphere comprising mostly % He. In an embodiment, a properly designed atmosphere means an atmosphere comprising % N₂. In an embodiment, a properly designed atmosphere means an atmosphere comprising mostly % N₂. In an embodiment, a properly designed atmosphere means an atmosphere comprising % H₂. In an embodiment, a properly designed atmosphere means an atmosphere comprising mostly % H₂. In an embodiment, a properly designed atmosphere means an atmosphere comprising an organic gas. In an embodiment, a properly designed atmosphere means an atmosphere comprising mostly an organic gas. In different embodiments, comprising mostly means 55 wt % or more, 75 wt % or more, 85 wt % or more, 95.5 wt % or more, 99.1 wt % or more and even 99.92 wt % or more. In another embodiment, comprising mostly means that only unavoidable impurities are present. For some applications, mixtures of the above mentioned atmospheres are desirable. In an embodiment, a properly designed atmosphere means an atmosphere comprising at least two of the gases mentioned above. In an embodiment, a properly designed atmosphere means an atmosphere comprising at least two of the gases mentioned above where one of them is % H₂. In an embodiment, a properly designed atmosphere means an atmosphere comprising at least two of the gases mentioned above where one of them is % Ar. In an embodiment, a properly designed atmosphere means an atmosphere comprising at least two of the gases mentioned above where one of them is an organic gas. In an embodiment, a properly designed atmosphere means an atmosphere comprising at least two of the gases mentioned above where one of them is % N₂. In an embodiment, a properly designed atmosphere means an atmosphere comprising a right carbon potential. In different embodiments, a right carbon potential is above 0.0001%, above 0.006%, above 0.11%, above 0.22%, above 0.31%, above 0.46%, above 0.81% and even above 1.1%. For certain applications, the carbon potential should be kept below a certain value. In different embodiments, a right carbon potential is below 5.9%, below 2.9%, below 1.9%, below 1.58%, below 0.98%, below 0.69%, below 0.49%, below 0.19%, below 0.09%. In an embodiment, the right carbon potential is the result of measuring the carbon potential in the atmosphere of the furnace or pressure vessel. In an alternative embodiment, the right carbon potential is the result of measuring the carbon potential in the atmosphere of the furnace or pressure vessel by means of oxygen and carbon probes and calculation of the carbon potential. In another alternative embodiment, the right carbon potential is the result of measuring the carbon potential in the atmosphere of the furnace or pressure vessel by means of NDIR (Non-Dispersive Infrared analyzer). In another alternative embodiment the right carbon potential is determined by simulation using ThermoCalc (version 2020b). In an embodiment, a properly designed atmosphere means an atmosphere comprising the right atomic nitrogen content. In different embodiments, the right atomic nitrogen content is 0.078 mol % or more, 0.78 mol % or more, 1.17 mol % or more, 1.56 mol % or more, 2.34 mol % or more, 3.55 mol % or more and even 4.68 mol % or more. For certain applications, excessive content is detrimental. In different embodiments, the right atomic nitrogen content is 46.8 mol % or less, 15.21 mol % or less, 11.31 mol % or less, 7.91 mol % or less, 5.46 mol % or less and even 3.47 mol % or less. For certain applications, the use of atmospheres comprising higher atomic nitrogen contents is preferred. In different embodiments, the right atomic nitrogen content is 2.14 mol % or more, 4.29 mol % or more, 6.24 mol % or more, 8.19 mol % or more, 10.14 mol % or more, 21.45 mol % or more and even 39.78 mol % or more. For certain applications, excessive content is detrimental. In different embodiments, the right atomic nitrogen content is 89 mol % or less, 69 mol % or less, 49 mol % or less, 29 mol % or less, 19 mol % or less, 14 mol % or less and even 9 mol % or less. For some applications, the atomic nitrogen content can be replaced by any alternative atmosphere providing the same percentual amount of atomic nitrogen. For some applications, atomic nitrogen is introduced by using ammonia (NH₃). In an embodiment, a properly designed atmosphere means an atmosphere comprising the right nitrogen content. In different embodiments, an atmosphere with the right nitrogen content is an atmosphere with a nitrogen content of 0.02 wt % or more, of 0.2 wt % or more, of 0.3 wt % or more, of 0.4 wt % or more, of 0.6 wt % or more, of 0.91 wt % or more and even of 1.2 wt % or more. For certain applications, an excessive content of nitrogen is detrimental. In different embodiments, an atmosphere with the right nitrogen content is an atmosphere with a nitrogen content of 3.9 wt % or less, of 2.9 wt % or less, of 1.9 wt % or less, of 1.4 wt % or less and even of 0.89 wt % or less. In an embodiment, a properly designed atmosphere means an atmosphere comprising ammonia. In different embodiments, the ammonia content is above 0.1 vol %, above 0.11 vol %, above 2.2 vol %, above 5.2 vol % and even above 10.2 vol %. For some applications, an excessive content of ammonia may be detrimental. In different embodiments, the ammonia content is below 89 vol %, below 49%, below 19 vol % below 14 vol %, below 9 vol % and even below 4 vol %. For some applications, it is better to control the pO₂ (oxygen partial pressure). In different embodiments, a properly designed atmosphere means an atmosphere where pO₂ is 4*10⁻¹ atm or lower, 4*10⁻³ atm or lower, 4*10⁻⁴ atm or lower, 4*10⁻¹⁰ atm or lower, 4*10⁻¹⁴ atm or lower, 4*10⁻¹⁸ atm or lower and even 4*10⁻²⁴ atm or lower. For some applications, excessively low pO₂ is surprisingly disadvantageous. In different embodiments, a properly designed atmosphere means an atmosphere where pO₂ is 4*10⁻³⁸ atm or higher, 4*10⁻³² atm or higher, 4*10⁻²⁸ atm or higher, 4*10⁻²⁴ atm or higher and even 4*10⁻¹⁹ atm or higher. For some applications, it has been proven more efficient to control pCO/pCO₂. In different embodiments, a properly designed atmosphere means an atmosphere where pCO/pCO₂ is 2*10⁻¹² or higher, 2*10⁻⁴ or higher, 2*10⁻¹ or higher, 2*10¹ or higher, 2*10³ or higher, 2*10⁵ or higher, 2*10⁷ or higher and even 2*10¹² or higher. Again, with surprise it has been found that sometimes an excessively high level of pCO/pCO₂ may be detrimental. In different embodiments, a properly designed atmosphere means an atmosphere where pCO/pCO₂ is 2*10¹⁴ or lower, 2*10¹² or lower, 2*10⁹ or lower and even 2*10⁶ or lower. For some applications, it has been proven more efficient to control pH₂/pH₂O. In different embodiments, a properly designed atmosphere means an atmosphere where pH₂/pH₂O is 2*10⁻⁸ or higher, 2*10⁻⁵ or higher, 2*10⁻² or higher, 2*10¹ or higher, 2*10² or higher, 2*10⁴ or higher, 2*10⁶ or higher and even 2*10¹¹ or higher. Again, with surprise it has been found that sometimes an excessively high level of pH₂/pH₂O may be detrimental. In different embodiments, a properly designed atmosphere means an atmosphere where pH₂/pH₂O is 2*10¹³ or lower, 2*10¹¹ or lower, 2*10⁸ or lower and even 2*10⁵ or lower. All the embodiments disclosed above can be combined among them in any combination, provided that they are not mutually exclusive. All the embodiments disclosed above can be combined among them and with any other embodiment disclosed in this document that relates to “a properly designed atmosphere” in any combination, provided that they are not mutually exclusive. Unless otherwise stated, the feature “method for the treatment of powder with microwaves” is defined throughout the present document in the form of different alternatives that are explained in detail below. In the system developed by the inventor, the powder is kept in movement (relative movement of the powder particles within each other) while being exposed to microwaves of the appropriate frequency range and with a proper power level while the powder is being exposed to a properly designed atmosphere (as previously defined). Since the inventor is not aware of the existence of any such system, a system for the reduction of the oxygen level content of metallic powder is claimed where the powder particles are kept in relative motion to each other (during enough time) and are exposed to a properly designed atmosphere while being irradiated with to microwaves of the appropriate frequency range and with a proper power level, is claimed. In different embodiments, a proper power level means 12 W or more, 120 W or more, 520 W or more, 1.2 KW or more, 6 KW or more, 12 KW or more and even 42 KW or more. For some applications, excessive power may be detrimental. In different embodiments, a proper power level means 900 KW or less, 400 KW or less, 90 KW or less, 49 KW or less and even 19 KW or less. Alternatively, for some applications, the proper power level refers to the microwave power/weight of processed powder. In different embodiments, a proper power level means 0.0002 W/Kg or more, 0.02 W/Kg or more, 0.2 W/Kg or more, 2 W/Kg or more, 20 W/Kg or more, 200 W/Kg or more and even 2000 W/Kg or more. For some applications, excessive power may be detrimental. In different embodiments, a proper power level means 90 KW/Kg or less, 20 KW/Kg or less, 9 KW/Kg or less and even 0.9 KW/Kg or less. In an embodiment, the power is the rating of the generator. In an embodiment, the power is the actual power leaving the generator. In an embodiment, the power is the power introduced in the chamber where the powder to be treated is contained. In an embodiment, a ceramic component is placed between the microwave applicator and the powder. In an embodiment, the ceramic acts as a heat insulator. In an embodiment, the ceramic has a cylindrical shape. In an embodiment, the ceramic has a low dielectric loss (in the terms and values described in this document). In an embodiment, the ceramic has a low dielectric loss at 2.45 GHz. In an alternative embodiment, the ceramic has a low dielectric loss at 915 MHz. In an embodiment, at least one of the ceramic components is kept in motion to secure relative displacement between the powder particles.

In an embodiment, the ceramic incorporates pales or vanes to better force the relative displacement between powder particles. In an embodiment, the ceramic incorporates internal protuberances (internal in the sense they progress in the direction where the powder is contained) that help secure relative displacement between the powder particles. For some applications, the movement is applied for enough time until the powder's oxygen content has been remarkably reduced. In an embodiment, “during enough time” means the time until the powder's oxygen content has been remarkably reduced. In an embodiment, the powder's oxygen content has been remarkably reduced means the oxygen content after the process is equal to the oxygen content before the process multiplied by a factor RF. In different embodiments, RF is smaller than 0.98, smaller than 0.74, smaller than 0.44, smaller than 0.24, smaller than 0.04, smaller than 0.004 and even smaller than 0.00004. For some applications, an excessively low value of RF is not appropriate. In different embodiments, RF is larger than 1.2*10⁻¹², larger than 1.2*10⁻¹⁰, larger than 1.2*10⁻⁸, larger than 1.2*10⁻⁶, larger than 1.2*10⁻⁴, larger than 1.2*10⁻², larger than 0.49 and even larger than 0.79. For some applications, it is more convenient to directly measure “during enough time”. In different embodiments. “enough time” is 1 minute or more, 35 minutes or more, 70 minutes or more, 125 minutes or more, 6 hours or more and even 18 hour or more. For some applications, excessively long times are disadvantageous. In different embodiments, enough time is 4000 hours or less, 400 hours or less, 40 hours or less, 19 hours or less and even 9 hours or less. In an embodiment, an appropriate frequency range should be applied. In an embodiment, an appropriate frequency range is 2.45 GHz +/−250 MHz. In another embodiment, an appropriate frequency range is 5.8 GHz +/−1050 MHz. In another embodiment, an appropriate frequency range is 915 MHz +/−250 MHz. For some applications, the method for the treatment of powder with microwaves as defined in any of the embodiments above can be advantageously applied to the powders or powder mixtures disclosed throughout in this document. Accordingly, all the embodiments disclosed above can be combined among them and with any other embodiment disclosed in this document in any combination, provided that they are not mutually exclusive. One very surprising and remarkable observation made is that less pores after sintering at low temperatures are obtained when using powders where the oxygen content has been reduced in the fashion described in this paragraph. The inventor has not found such kind of observations in the open literature, and therefore claims a component whose manufacturing process comprises sintering and which also comprises the use of metallic powders whose oxygen content has been remarkably reduced (in the terms described above in this paragraph) through a process that involves the heating up the powder with a system comprising microwave heating in the appropriate frequency range (in the terms described above in this paragraph). In an embodiment, the metallic powders used comprise powders of the present invention. In an embodiment, the component has been shaped with the method of the present invention previous to the sintering step. In an embodiment, the metallic powders used comprise at least two powders of the present invention with different nature. In an embodiment, the sintering step comprises a dwell at low effective temperatures. In different embodiments, the dwell is at least 32 minutes long, at least 62 minutes long, at least 122 minutes long and even at least 3.5 hours long. In different embodiments, the dwell is at most 38 hours long, at most 18 hours long, at most 9 hours long and even at most 2.9 hours long. In different embodiments, a low effective temperature for the sintering is 655° C. or more, 705° C. or more, 755° C. or more, 805° C. or more and even 855° C. or more. In different embodiments, a low effective temperature for the sintering is 0.51*Tm or more, 0.56*Tm or more, 0.61*Tm or more and even 0.64*Tm or more. In different embodiments, a low effective temperature for the sintering is 1190° C. or less, 1140° C. or less, 1090° C. or less, 1040° C. or less and even 990° C. or less. In different embodiments, a low effective temperature for the sintering is 0.83*Tm or less, 0.79*Tm or less, 0.74*Tm or less and even 0.69*Tm or less. When not otherwise indicated, in this document, it is understood as melting temperature (Tm) of a material the temperature at which the first liquid forms. In an embodiment, Tm refers to the melting temperature of the metallic powder species with the highest volume fraction. In an alternative embodiment. Tm refers to the melting temperature of the metallic powder species with the highest weight fraction. In another alternative embodiment, Tm refers to the melting temperature of the metallic powder species with the highest melting temperature. In another alternative embodiment, Tm refers to the melting temperature of the metallic powder species with the lowest melting temperature. In another alternative embodiment, Tm refers to the melting temperature weight factor average of all the metallic powder species (mass-weighted arithmetic mean). In another alternative embodiment, Tm refers to the melting temperature of a powder mixture. Unless otherwise stated, the feature “melting temperature of a powder mixture” is defined throughout the present document in the form of different alternatives that are explained in detail below. In an embodiment, the melting temperature of a powder mixture refers to the melting temperature of the powder with the highest volume fraction in the powder mixture. In an alternative embodiment, the melting temperature of a powder mixture refers to the melting temperature of the powder with the highest weight fraction in the powder mixture. In another alternative embodiment, the melting temperature of a powder mixture refers to the melting temperature of the powder with the lowest volume fraction in the powder mixture. In another alternative embodiment, the melting temperature of a powder mixture refers to the melting temperature of the powder with the lowest weight fraction in the powder mixture. In another alternative embodiment, the melting temperature of a powder mixture refers to the melting temperature of the powder with the highest melting point in the powder mixture. In another alternative embodiment, the melting temperature of a powder mixture refers to the mean melting temperature of at least two critical powders (as defined below) in the powder mixture. In another alternative embodiment, the melting temperature of a powder mixture refers to the mean melting temperature of the metal comprising powder mixture (mass-weighted arithmetic mean, where the weights are the weight fractions). In another alternative embodiment, the melting temperature of a powder mixture refers to the melting temperature of the critical powder (as defined below) with the lowest melting point in the powder mixture. In another alternative embodiment, the melting temperature of a powder mixture refers to the mean melting temperature of the two critical powders (as defined below) with the lowest melting points in the powder mixture (mass-weighted arithmetic mean, where the weights are the weight fractions). In another alternative embodiment, the melting temperature of a powder mixture refers to the mean melting temperature of the three critical powders (as defined below) with the lowest melting points in the powder mixture (mass-weighted arithmetic mean, where the weights are the weight fractions). In another alternative embodiment, the melting temperature of a powder mixture refers to the mean melting temperature of the two critical powders (as defined below) with the lowest melting points in the powder mixture (volume-weighted arithmetic mean, where the weights are the volume fractions). In another alternative embodiment, the melting temperature of a powder mixture refers to the mean melting temperature of the three critical powders (as defined below) with the lowest melting points in the powder mixture (volume-weighted arithmetic mean, where the weights are the volume fractions). In another alternative embodiment, the melting temperature of a powder mixture refers to the melting temperature of the critical powder (as defined below) with the highest melting point in the powder mixture. In another alternative embodiment, the melting temperature of a powder mixture refers to the mean melting temperature of the two critical powders (as defined below) with the highest melting points in the powder mixture (mass-weighted arithmetic mean, where the weights are the weight fractions). In another alternative embodiment, the melting temperature of a powder mixture refers to the mean melting temperature of the three critical powders (as defined below) with the highest melting points in the powder mixture (mass-weighted arithmetic mean, where the weights are the weight fractions). In another alternative embodiment, the melting temperature of a powder mixture refers to the mean melting temperature of the two critical powders (as defined below) with the highest melting points in the powder mixture (volume-weighted arithmetic mean, where the weights are the volume fractions). In another alternative embodiment, the melting temperature of a powder mixture refers to the mean melting temperature of the three critical powders (as defined below) with the highest melting points in the powder mixture (volume-weighted arithmetic mean, where the weights are the volume fractions). In an embodiment, the critical powder (as defined below) is a metallic powder. Unless otherwise stated, the feature “critical powder” is defined throughout the present document in the form of different alternatives that are explained in detail below. For some applications, a critical powder is a powder which is present in a certain weight percentage in the powder mixture. In different embodiments, a critical powder is a powder which is at least 0.06 wt % at least 0.6 wt %, at least 1.2 wt %, at least 2.6 wt %, at least 6 wt %, at least 11 wt %, at least 21 wt %, at least 36 wt % and even at least 52 wt % of the powder mixture. In an alternative embodiment, the percentages disclosed above are in respect of the total weight (including the weight of the polymer and/or binder). Alternatively, for some applications, a critical powder is a powder which is present in a certain volume percentage in the powder mixture. In different embodiments, a critical powder is a powder which is at least 0.06 vol %, at least 0.6 wt %, at least 1.2 vol %, at least 2.6 vol %, at least 6 vol %, at least 11 vol %, at least 21 vol %, at least 36 vol % and even at least 52 vol % of the powder mixture. In another alternative embodiment, the percentages disclosed above are in respect of the total volume (including the volume of the polymer and/or binder). All the embodiments disclosed above can be combined among them and with any other embodiment disclosed in this document that relates to a “critical powder” in any combination, provided that they are not mutually exclusive. In another alternative embodiment, the melting temperature of a powder mixture refers to the melting temperature of the relevant powder (as defined below) with the lowest melting point in the powder mixture. In another alternative embodiment, the melting temperature of a powder mixture refers to the mean melting temperature of the two relevant powders (as defined below) with the lowest melting points in the powder mixture (mass-weighted arithmetic mean, where the weights are the weight fractions). In another alternative embodiment, the melting temperature of a powder mixture refers to the mean melting temperature of the three relevant powders (as defined below) with the lowest melting points in the powder mixture (mass-weighted arithmetic mean, where the weights are the weight fractions). In another alternative embodiment, the melting temperature of a powder mixture refers to the mean melting temperature of the two relevant powders (as defined below) with the lowest melting points in the powder mixture (volume-weighted arithmetic mean, where the weights are the volume fractions). In another alternative embodiment, the melting temperature of a powder mixture refers to the mean melting temperature of the three relevant powders (as defined below) with the lowest melting points in the powder mixture (volume-weighted arithmetic mean, where the weights are the volume fractions). In another alternative embodiment, the melting temperature of a powder mixture refers to the melting temperature of the relevant powder (as defined below) with the highest melting point in the powder mixture.

In another alternative embodiment, the melting temperature of a powder mixture refers to the mean melting temperature of the two relevant powders (as defined below) with the highest melting points in the powder mixture (mass-weighted arithmetic mean, where the weights are the weight fractions). In another alternative embodiment, the melting temperature of a powder mixture refers to the mean melting temperature of the three relevant powders (as defined below) with the highest melting points in the powder mixture (mass-weighted arithmetic mean, where the weights are the weight fractions). In another alternative embodiment, the melting temperature of a powder mixture refers to the mean melting temperature of the two relevant powders (as defined below) with the highest melting points in the powder mixture (volume-weighted arithmetic mean, where the weights are the volume fractions). In another alternative embodiment, the melting temperature of a powder mixture refers to the mean melting temperature of the three relevant powders (as defined below) with the highest melting points in the powder mixture (volume-weighted arithmetic mean, where the weights are the volume fractions). In an embodiment, the relevant powder (as defined below) is a metallic powder. Unless otherwise stated, the feature “relevant powder” is defined throughout the present document in the form of different alternatives, that are explained in detail below. In different embodiments, a powder is considered relevant when the percentage by weight of this powder is 2 wt % or more, 5.5 wt % or more, 10.5 wt % or more, 15.5 wt % or more, 25.5 wt % or more and even 55.5 wt % or more (taking into account all the metallic powder). In another alternative embodiment, there is only one relevant powder, being the one with the highest weight percent. In another alternative embodiment a relevant powder is any of the powders or powder mixtures disclosed throughout this document. All the embodiments disclosed above can be combined among them and with any other embodiment disclosed in this document that relates to a “relevant powder” in any combination, provided that they are not mutually exclusive. In another alternative embodiment, the melting temperature of a powder mixture refers to the mean melting temperature of the powder mixture. In an embodiment, the powder is a metallic powder. In an embodiment, the above disclosed for the sintering can also be extended to other consolidation treatments. All the embodiments disclosed above can be combined among them and with any other embodiment disclosed in this document that relates to “the melting temperature of a powder mixture” in any combination, provided that they are not mutually exclusive.

When producing metal-comprising highly geometrically complex components with high mechanical properties at low cost, conventional machining processes reach good mechanical properties but with severe limitations when it comes to geometrical flexibility (especially for internal features) and geometrical complexity comes at high cost, in addition, environmental impact is highest due to the low resource efficiency. Other manufacturing technologies such as, but not limited to, traditional Powder Bed AM technologies reach decent mechanical properties and has a good geometrical flexibility with some limitations in cooling channels and need for supports, but at very high cost and environmental impact, Low temperature MAM methods can be applied with a satisfactory geometrical flexibility and is good in terms of cost and environmental impact, although this technology has limitations due to tendency to collapse upon debinding and manufactured components have poor mechanical properties.

The inventor has found that components with high mechanical properties, particularly high mechanical strength, elongation and toughness can be manufactured with a high design flexibility at a low cost and with a low environmental impact employing some low temperature MAM methods involving an organic material (such as, but not limited to, a polymer and/or binder and/or mixtures thereof) when the method steps disclosed in the following paragraphs are applied.

In an embodiment, the method for manufacturing at least part of a metal comprising component comprises the following steps:
providing a powder or powder mixture comprising at least a metal or a metal alloy in powdered form:
forming the component from the powder or powder mixture comprising at least a metal or a metal alloy in powdered form using a metal additive manufacturing (MAM) method, wherein the MAM method comprises the use of a polymer and/or binder;
applying a debinding to eliminate at least part of the polymer and/or binder;
applying a consolidation method to achieve a right apparent density:
applying a high temperature, high pressure treatment; and optionally,
applying a heat treatment and/or machining.

Some special implementations of the method (also referred as the manufacturing method) will be discussed as well. For some applications, instead using a metal additive manufacturing (MAM) method, the component or a part of the component can be advantageously formed using a mold filled with a metal or metal alloy comprising powder or powder mixture. The inventor has found that the manufacture of components can be performed in a mold having the desired form of the component to be manufactured (the mold has the required form so that the powder filling the mold has the desired form taking into account the shrinkage that takes place during the manufacturing process described in this invention, it must also be taken into account that often enough the final geometry is achieved with some kind of subtractive manufacturing like machining or with other additive manufacturing processes other than the one described in this invention) and filled with a powder provided that the method steps disclosed in this document are followed. In an embodiment, the method for manufacturing at least part of a metal comprising component comprises the following steps:
providing a mold at least partly manufactured by additive manufacturing;
filling the mold with a powder or a powder mixture comprising at least a metal or a metal alloy in powdered form;
forming the component applying pressure and/or temperature;
applying a debinding to eliminate at least part of the mold;
applying a consolidation method to achieve a right apparent density:
applying a high temperature, high pressure treatment; and optionally,
applying a heat treatment and/or machining.

For some applications, the nitrogen and/or oxygen content in the component particularly after applying the debinding, may have an impact on the mechanical properties which can be reached after applying the consolidation treatment and thus, the application of a fixing step for setting the oxygen and/or nitrogen level of the metallic part of the component before the applying the consolidation treatment may help to reach the required mechanical properties in the manufactured component.

In an embodiment, the method for manufacturing at least part of a metal comprising component comprises the following steps:
providing a powder or powder mixture comprising at least a metal or a metal alloy in powdered form;
forming the component from the powder or powder mixture comprising at least a metal or a metal alloy in powdered form using a metal additive manufacturing (MAM) method, wherein the MAM method comprises the use of a polymer and/or binder;
applying a debinding to eliminate at least part of the polymer and/or binder;
setting the oxygen and/or nitrogen level of the metallic part of the component;
applying a consolidation method;
applying a high temperature, high pressure treatment; and optionally,
applying a heat treatment and/or machining.

This fixing step can also be advantageous applied when forming the component using a mold filled with a metal or metal alloy comprising powder or powder mixture following the method steps previously disclosed.

In an embodiment, the method for manufacturing at least part of a metal comprising component comprises the following steps:
providing a mold at least partly manufactured by additive manufacturing;
filling the mold with a powder or a powder mixture comprising at least a metal or a metal alloy in powdered form;
forming the component applying pressure and/or temperature;
applying a debinding to eliminate at least part of the mold;
setting the oxygen and/or nitrogen level of the metallic part of the component;
applying a consolidation method;
applying a high temperature, high pressure treatment; and
optionally,
applying a heat treatment and/or machining.

For some applications, the high temperature, high pressure treatment (also referred as the densification step) is optional and therefore can be avoided. In an embodiment, the high temperature, high pressure treatment is skipped. For certain applications, many additional steps can be included in the method, some of which will be discussed in detail below.

The first thing that should be mentioned is that it is very surprising that the present method works and does so for complex geometry components (even including those with complex internal features), without cracks, with good dimensional accuracy and high levels of performance. Especially, when taking into account the limitations of the HIP, CIP and MIM methods.

For some applications, very surprisingly, it is advantageous to manufacture a component in different parts that can be assembled together. In an embodiment, at least part of a metal comprising component refers to a part of a component. On the other hand, for some applications, the entire component is advantageously manufactured using the methods disclosed above. In an embodiment, when the entire component is manufactured, the above disclosed for the part of a component applies to the entire component. Accordingly, in some embodiments, the wording “at least part of a metal comprising component” can be replaced by “a metal comprising component”. For certain applications, it is advantageous to manufacture the component (or at least the part of the component manufactured using the methods disclosed above) using different materials. In an embodiment, the manufactured component comprises at least two different materials. In another embodiment, the manufactured component comprises at least three different materials. In another embodiment, the manufactured component comprises at least four different materials.

The inventor has found that for some applications, the combination of the methods disclosed above with the “proper geometrical design strategy disclosed” in this document is particularly advantageous. Accordingly, any embodiment that relates to a “proper geometrical design strategy” disclosed in this document can be combined with the above disclosed methods in any combination, provided that they are not mutually exclusive.

For some applications, the method used to manufacture the powder or powder mixture has a great relevance in the mechanical properties which can be achieved in the component. The inventor has surprisingly found that, when following the method steps disclosed above, very high performant components can be obtained even when the powder or powder mixture used to manufacture the component comprises a low cost powder, like for example a water atomized powder and/or a powder obtained by oxide reduction. In an embodiment, the powder is a powder obtained by water atomization. In another embodiment, the powder is a powder obtained by oxide reduction. In an embodiment, the powder mixture comprises at least a powder obtained by water atomization. In an embodiment, the powder mixture comprises at least a powder obtained by oxide reduction. Other technologies may also be advantageous to obtain the powder or at least part of the powders contained in the powder mixture. In an embodiment, the powder is obtained by mechanical action. In another embodiment, the powder is mechanically crushed. In an embodiment, the powder mixture comprises at least a powder obtained by mechanical action. In an embodiment, the powder mixture comprises at least a powder mechanically crushed. In an embodiment, the powder mixture comprises at least a powder obtained by attrition. In an embodiment, the powder mixture comprises at least a powder obtained by milling. In an embodiment, the powder mixture comprises at least a powder obtained by ball milling. In an embodiment, the powder mixture comprises at least a powder obtained by kinetic energy breaking. In an embodiment, the powder mixture comprises at least a powder obtained through controlled crushing. In an embodiment, the powder mixture comprises at least a powder obtained by comminution. For certain applications, the use of irregular powders is preferred. In an embodiment, the powder or powder mixture comprises an irregular powder. In an embodiment, the powder is an irregular powder. In an embodiment, the powder mixture comprises at least one irregular powder. In another embodiment, the powder mixture comprises at least two irregular powders. In an embodiment, an irregular powder is a non-spherical powder. In different embodiments, a non-spherical powder is a powder with a sphericity below 99%, below 89%, below 79%, below 74% and even below 69%. For some applications, the use of powders with very low sphericity is disadvantageous. In different embodiments, a non-spherical powder is a powder with a sphericity above 22%, above 36%, above 51% and even above 64%. The inventor has also found that in some applications, the use of spherical powders is particularly advantageous. In an embodiment, the powder or powder mixture comprises a spherical powder. In an embodiment, the powder mixture comprises a spherical powder. In an embodiment, a spherical powder means a powder obtained by gas atomization, centrifugal atomization and/or a powder rounded with a plasma treatment. In an embodiment, the powder or powder mixture comprises a powder obtained by gas atomization. In an embodiment, the powder or powder mixture comprises at least one powder obtained by centrifugal atomization. In an embodiment, the powder or powder mixture comprises a powder rounded with a plasma treatment. In an embodiment, the powder mixture comprises at least one powder obtained by gas atomization. In an embodiment, the powder mixture comprises at least one powder obtained by centrifugal atomization. In an embodiment, the powder mixture comprises at least one powder obtained rounded with a plasma treatment. In different embodiments, a spherical powder is a powder with a sphericity above 76%, above 82%, above 92% k, above 96% and even 100%. The sphericity of the powder refers to a dimensionless parameter defined as the ratio between the surface area of a sphere having the same volume as the particle and the surface area of the particle. In an embodiment, sphericity (Ψ) is calculated using the formula: Ψ=[Π^{1/3}*(6*Vp)^{2/3}]/Ap. In this formula, Tr refers to the mathematical constant commonly defined as the ratio of a circle's circumference to its diameter, Vp is the volume of the particle and Ap is the surface area of the particle. In an embodiment, the sphericity of the particles is determined by dynamic image analysis. In an alternative embodiment, the sphericity is measured by light scattering diffraction. In an embodiment, the above disclosed refers to the powder or powder mixture used to fill the mold. In an embodiment, the above disclosed refers to the powder or powder mixture used to form the component by MAM.

In an embodiment, the powder or powder mixture comprises, but is not limited to, at least one of the following metal or metal alloys in powdered form: iron or an iron based alloy, a steel, a stainless steel, nickel or a nickel based alloy, copper or a copper based alloy, chromium or a chromium based alloy, cobalt or a cobalt based alloy, molybdenum or a molybdenum based alloy, manganese or a manganese based alloy, aluminium or an aluminium based alloy, tungsten or a tungsten based alloy, titanium or a titanium based alloy, lithium or a lithium based alloy, magnesium or a magnesium based alloy, niobium or a niobium based alloy, zirconium or a zirconium based alloy, silicon or a silicon based alloy, tin or a tin based alloy, tantalum or a tantalum based alloy and/or mixtures thereof. In an embodiment, the powder or powder mixture comprises a metal or metal based alloy powder. In an embodiment, the powder or powder mixture comprises a metal based alloy powder. In an embodiment, the powder mixture comprises at least one metal based alloy powder. In an embodiment, the powder mixture comprises at least one metal or metal based alloy powder. In an embodiment, the powder mixture comprises at least a critical powder (as previously defined) which is a metal based alloy powder. In an embodiment, the powder mixture comprises at least a critical powder (as previously defined) which is a metal or metal based alloy powder. In an embodiment, the powder mixture comprises at least a relevant powder (as previously defined) which is a metal based alloy powder. In an embodiment, the powder mixture comprises at least a relevant powder (as previously defined) which is a metal or metal based alloy powder. For certain applications, the use of a metal alloy powder or a powder mixture having an overall composition corresponding to that of a metal based alloy is preferred. In an embodiment, the powder is a metal based alloy powder. In an embodiment, the powder is a metal or metal based alloy powder. In an embodiment, the powder mixture has a mean composition corresponding to that of a metal based alloy. In an embodiment, the powder mixture has a mean composition corresponding to that of a metal or metal based alloy. In an embodiment, the metal is iron. In an embodiment, the metal is titanium. In an embodiment, the metal is aluminium. In an embodiment, the metal is magnesium. In an embodiment, the metal is nickel. In an embodiment, the metal is copper. In an embodiment, the metal is niobium. In an embodiment, the metal is zirconium. In an embodiment, the metal is silicon. In an embodiment, the metal is chromium. In an embodiment, the metal is cobalt. In an embodiment, the metal is molybdenum. In an embodiment, the metal is manganese. In an embodiment, the metal is tungsten. In an embodiment, the metal is lithium. In an embodiment, the metal is tin. In an embodiment, the metal is tantalum. For certain applications, the use of mixtures of the above disclosed metal or metal based alloys is preferred. The method is not limited to the use of these metal or metal based alloys, however. Accordingly, any other powder or powder mixture comprising at least a metal or a metal based alloy can also be used. For some applications, the use of any of the powders or powder mixtures disclosed throughout this document is particularly advantageous. In this regard, the inventor has found that for some applications, the use of a nitrogen austenitic steel (a nitrogen austenitic steel with the composition previously disclosed is this document) in powdered form is surprisingly advantageous. In an embodiment, the powder or powder mixture comprises a nitrogen austenitic steel powder. In an embodiment, the powder mixture comprises at least one nitrogen austenitic steel powder. For certain applications, the use of a nitrogen austenitic steel powder or a powder mixture having an overall composition corresponding to that of a nitrogen austenitic steel is preferred. In an embodiment, the powder is a nitrogen austenitic steel powder. In an embodiment, the powder mixture has a mean composition corresponding to that of a nitrogen austenitic steel. In some embodiments, the use of powder or powder mixtures according to the mixing strategies previously defined in this document. Accordingly, all the embodiments related to the powders or powders mixtures disclosed in the mixing strategies can be combined with the present method in any combination. In an embodiment, the powder mixture comprises at least a LP and SP powder (as previously defined). In an embodiment, the powder or powder mixture comprises a LP powder (as previously defined). In an embodiment, the powder or powder mixture comprises a SP powder (as previously defined). In an embodiment, the powder or powder mixture comprises at least a powder P1, P2, P3 and/or P4 (as previously defined). In some embodiments, the powders and/or powder mixtures disclosed in patent application number PCT/EP2019/075743, the contents of which are incorporated herein by reference in their entirety may be advantageously used. For some applications, the use of powders comprising % Y, % Sc, % REE, % Al and/or % Ti is surprisingly advantageous. In some embodiments, the use of a powder or powder mixture comprising % Y, % Sc, and/or % REE (with the % Y, % Sc, and/or % REE contents disclosed throughout this document) is particularly advantageous. In an embodiment, the powder or powder mixture comprises the right content of % Y+% Sc+% REE. In an embodiment, the powder mixture comprises at least one powder with the right content of % Y+% Sc+% REE. For some applications, the use of a powder or powder mixture comprising % Y, % Sc, % REE and/or % Al is preferred. In an embodiment, the powder or powder mixture comprises the right content of % Al+% Y+% Sc+% REE. In an embodiment, the powder mixture comprises at least one powder with the right content of % Al+% Y+% Sc+% REE. For some applications, the use of a powder or powder mixture comprising % Y, % Sc, % REE and/or % Ti is preferred. In an embodiment, the powder or powder mixture comprises the right content of % Ti+% Y+% Sc+% REE, being % REE as previously defined. In an embodiment, the powder mixture comprises at least one powder with the right content of % Ti+% Y+% Sc+% REE, being % REE as previously defined. For some applications, the use of a powder or powder mixture comprising % Y, % Sc, % REE, % Al and/or % Ti is advantageous. In an embodiment, the powder or powder mixture comprises the right content of % Al+% Ti+% Y+% Sc+% REE, being % REE as previously defined. In an embodiment, the powder mixture comprises at least one powder with the right content of % Al+% Ti+% Y+% Sc+% REE, being % REE as previously defined. Unless otherwise stated, the feature “right content” is defined throughout the present document in the form of different alternatives that are explained in detail below. In different embodiments, the right content is 0.012 wt % or more, 0.052 wt % or more, 12 wt % or more, 0.22 wt % or more, 0.42 wt % or more and even 0.82 wt % or more. For certain applications, an excessive content is detrimental to mechanical properties. In different embodiments, the right content is 6.8 wt % or less, 3.9 wt % or less, 1.4 wt % or less, 0.96 wt % or loss, 0.74 wt % or less and even 0.48 wt % or less. Very surprisingly, for some applications it is possible to attain extraordinary mechanical properties by using systems comprising powders comprising % Y, % Sc, % REE and/or % Ti. For some applications, it is very important to select a very precise level of % Ti, % Y, % Sc and/or % REE and for those applications the concept of yttrium equivalent is very interesting. Unless otherwise stated, the feature “right level of % Yeq(1)” is defined throughout the present document in the form of different alternatives, that are explained in detail below. In an embodiment, the following concept of yttrium equivalent is employed: % Yeq(1)=% Y+1.55*(% Sc+% Ti)+0.68*% REE, being % REE as previously defined. In different embodiments, the right level of % Yeq(1) has to be higher than 0.03 wt %, higher than 0.06 wt %, higher than 0.12 wt %, higher than 0.6 wt %, higher than 1.2 wt %, higher than 2.1 wt % and even higher than 3.55 wt %. For certain applications, an excessive content of % Yeq(1) is detrimental to mechanical properties. In different embodiments, the right level of % Yeq(1) has to be lower than 8.9 wt %, lower than 4.9 wt %, lower than 3.9 wt %, lower than 2.9 wt %, lower than 2.4 wt %, lower than 1.9 wt %, lower than 1.4 wt %, lower than 0.9 wt % and even lower than 0.4 wt %. In an alternative embodiment, what has been said in this paragraph as well as the definition of % Yeq(1) are modified to ignore % Ti, so that the % Ti contained in the material is not taken into account for the calculations of % Yeq(1). In an embodiment, the powder or powder mixture comprises the right level of % Yeq(1). In another embodiment, at least one of the powders in the powder mixture comprises the right level of % Yeq(1). In another embodiment, the metallic part of the component comprises the right level of % Yeq(1) at some point during the application of the method. In another embodiment, the metallic part of the manufactured component comprises the right level of % Yeq(1). In another embodiment, at least one of the materials comprised in the manufactured component comprises the right level of % Yeq(1). For some applications, a certain relation of the oxygen content to the content of % Y, % Sc, % Ti and % REE is advantageous. In an embodiment, the % O content is chosen to comply with the following formula %₀ s KYS*(% Y+1.98*% Sc+2.47*% Ti+0.67*% REE), being % REE as previously defined. In another embodiment, the % O content is chosen to comply with the following formula KYI*(% Y+1.98*% Sc+2.47% Ti+0.67*% REE)<% O S KYS*(% Y+1.98*% Sc+2.47*% Ti+0.67% REE), being % REE as previously defined. In different embodiments, KYI is 3800, 2900, 2700, 2650, 2600, 2400, 2200, 2000 and even 1750. In different embodiments, KYS is 2100, 2350, 2700, 2750, 2800, 3000, 3500, 4000, 4500 and even 8000. In an alternative embodiment, what has been disclosed above in this paragraph is modified to ignore % Ti, so that the % Ti contained in the material is not taken into account for the calculations of acceptable % O. In an embodiment the content of % O, % Y, % Sc, % Ti and % REE refers to the content of % O, % Y, % Sc, % Ti and % REE in the powder or powder mixture. In another embodiment the content of % O, % Y, % Sc, % Ti and % REE refers to the content of % O, % Y, % Sc, % Ti and % REE in at least one of the powders in the powder mixture. The inventor has found that for some applications, very high mechanical properties especially in terms of yield strength combined with elongation can be reached when the powder mixture comprises at least one powder with the proper level of % V, % Nb, % Ta, % Ti, % Mn, % Al, % Si, % Moeq and/or % Cr (the proper levels as disclosed below). In an embodiment, the powder mixture comprises at least one powder with the proper level of % V, % Nb, % Ta and/or % Ti. In an embodiment, the powder mixture comprises at least one powder with the proper level of % Mn. In an embodiment, the powder mixture comprises at least one powder with the proper level of % Al and/or % Si. In an embodiment, the powder mixture comprises at least one powder with the proper level of % Moeq (% Moeq=% Mo+½*% W). In an embodiment, the powder mixture comprises at least one powder with the proper level of % Cr. In different embodiments, the proper level is more than 8 wt %, more than 21 wt %, more than 41 wt % and even more than 51 wt %. For certain applications, an excessively high level is detrimental. In different embodiments, the proper level is less than 89 wt %, less than 79 wt % and even less than 69 wt %. For certain applications, the content of % V+% Al+% Cr+% Mo+% Ta+% W+% Nb in the powder or powder mixture is relevant to the mechanical properties which can be achieved in the component. Unless otherwise stated, the feature “right level of % V+% Al+% Cr+% Mo+% Ta+% W+% Nb” is defined throughout the present document in the form of different alternatives that are explained in detail below. In different embodiments, a right level of % V+% Al+% Cr+% Mo+% Ta+% W+% Nb is 0.12 wt % or more, 0.6 wt % or more, 1.1 wt % or more, 2.1 wt % or more, 3.1 wt % or more, 5.6 wt % or more and even 11 wt % or more. For certain applications, an excessive content is detrimental to mechanical properties. In different embodiments, a right level of % V+% Al+% Cr+% Mo+% Ta+% W+% Nb is 34 wt % or less, 29 wt % or less, 19 wt % or less, 9 wt % or less and even 4 wt % or less. In an embodiment, the powder or powder mixture comprises a right level of % V+% Al+% Cr+% Mo+% Ta+% W+% Nb. In an embodiment, the powder mixture comprises at least one powder with a right level of % V+% Al+% Cr+% Mo+% Ta+% W+% Nb. The inventor has found that some applications benefit from the use of powder mixtures comprising pure iron, carbonyl iron, graphite and/or mixtures thereof. In an embodiment, the powder mixture comprises carbon. In an embodiment, the powder mixture comprises carbon in graphite form. In an embodiment, the carbon is constituted to at least 52% graphite. In an embodiment, the powder mixture comprises synthetic graphite. In an embodiment, the carbon is constituted to at least 52% synthetic graphite. In an embodiment, the powder mixture comprises carbon in natural graphite form. In an embodiment, the carbon is constituted to at least 52% natural graphite. In an embodiment, the powder mixture comprises carbon in fullerene form. In an embodiment, the carbon is constituted to at least 52% of fullerene carbon. In an embodiment, the powder mixture comprises carbonyl iron. In an embodiment, the powder or powder mixture comprises a powder of pure iron. In an embodiment, the powder or powder mixture comprises a powder of atomized pure iron. In an embodiment, the powder or powder mixture comprises a powder of atomized pure iron which is mainly spherical. In an embodiment, the powder or powder mixture comprises a powder of atomized pure iron which is spherical. In an embodiment, the powder or powder mixture comprises a powder of pure iron obtained by gas atomization. In an embodiment, the powder or powder mixture comprises a powder of pure iron obtained by centrifugal atomization. In an embodiment, the powder or powder mixture comprises a pure iron powder. In an embodiment, the powder or powder mixture comprises a powder of iron and impurities. In an embodiment, the powder or powder mixture comprises a powder of iron, carbon and impurities. In an embodiment, the powder or powder mixture comprises a powder of iron, carbon, nitrogen and impurities. In an embodiment, the powder or powder mixture comprises a powder which is iron and trace elements. In different embodiments, trace elements are 0.9 wt % or less, 0.4 wt % or less, 0.18 wt % or less and even 0.08 wt % or less. In an embodiment, the above disclosed refers to the powder or powder mixture used to fill the mold. In an embodiment, the above disclosed refers to the powder or powder mixture used to form the component by MAM.

The inventor has surprisingly found that for some applications, particularly when the powder used is a steel powder or a powder mixture with the overall composition of a steel, the presence of a certain content of % Moeq (% Moeq-% Mo+½% W) and a certain content of % C or % Ceq may help to set the right levels of oxygen and/or nitrogen in the metallic part of the component. In an embodiment, the powder or powder mixture comprises a certain content of % Moeq and a certain content of % C. In another embodiment, the powder or powder mixture comprises a certain content of % Moeq and a certain content of % Ceq. Unless otherwise stated, the feature “certain content of % Moeq” is defined throughout the present document in the form of different alternatives, that are explained in detail below. In different embodiments, a certain content of % Moeq is more than 0.11 wt %, more than 0.21 wt %, more than 0.51 wt %, more than 1.05 wt % and even more than 2.05 wt %. On the other hand, too high contents of % Moeq will lead to situations where mechanical properties can be negatively affected. In different embodiments, a certain content of % Moeq is less than 14 wt %, less than 9.6 wt %, less than 4.8 wt % and even less than 3.9 wt %. Unless otherwise stated, the feature “certain content of % C” is defined throughout the present document in the form of different alternatives, that are explained in detail below. In different embodiments, a certain content of % C is more than 0.11 wt %, more than 0.16 wt %, more than 0.21 wt % and even more than 0.31 wt %. On the other hand, for some applications, the content of % C should be controlled. In different embodiments, a certain content of % C is less than 0.98 wt %, less than 0.78 wt %, less than 0.58 wt %, less than 0.48 wt % and even less than 0.39 wt %. In an alternative embodiment, the above disclosed contents of % C refer to the contents of % Ceq, being % Ceq=% C+0.86*% N+1.2*% B. All the embodiments disclosed above can be combined among them in any combination, provided that they are not mutually exclusive, for example a steel powder where % Moeq is more than 0.11 wt % and % C is less than 0.98 wt %: or for example a steel powder where % Moeq is less than 14 wt % and % Ceq is more than 0.11 wt %. For certain applications, what is more relevant is the presence of a certain content of % C or % Ceq and a certain content of % Moeq (as previously defined) in at least one of the powders comprised in the powder mixture. In an embodiment, the powder mixture comprises at least one powder with a certain content of % Moeq and a certain content of % C. In another embodiment, the powder mixture comprises at least one powder a certain content of % Moeq and a certain content of % Ceq. In an embodiment, the powder with a certain content of % C or % Ceq and a certain content of % Moeq is a critical powder (as previously defined). In another embodiment, the powder with a certain content of % C or % Ceq and a certain content of % Moeq is a relevant powder (as previously defined). For certain applications, what is more relevant is the presence of a certain content of % C or % Ceq and a certain content of % Moeq (% Moeq is as previously defined) in the manufactured component (or at least in a material comprised in the manufactured component). In an embodiment, the manufactured component comprises a certain content of % Moeq and a certain content of % C. In another embodiment, the manufactured component comprises a certain content of % Moeq and a certain content of % Ceq. For certain applications, the presence of a low enough content of % Cr may help to set the right levels of oxygen and/or nitrogen in the metallic part of the component. In some embodiments, the powder or powder mixture further comprises a low enough content of % Cr. In an embodiment, the powder or powder mixture comprises a certain content of % C, a certain content of % Moeq and a low enough content of % Cr. In another embodiment, the powder or powder mixture comprises a certain content of % Ceq, a certain content of % Moeq and a low enough content of % Cr. Unless otherwise stated, the feature “low enough content of % Cr” is defined throughout the present document in the form of different alternatives, that are explained in detail below. In different embodiments, a low enough content of % Cr is less than 2.9 wt %, less than 1.9 wt %, less than 0.9 wt %, less than 0.4 wt %, less than 0.28 wt % and even less than 0.09 wt %. All the embodiments disclosed above can be combined among them in any combination, provided that they are not mutually exclusive, for example a steel powder where % Moeq is above 0.11 wt %, % C is below 0.98 wt % and % Cr is below 2.9 wt %; or for example a steel powder where % Moeq is below 14 wt %, % Ceq is above 0.11 wt % and % Cr is below 1.9 wt %. For Certain applications, the presence of a certain content of % Cr+% V+% Ti+% Ta+% Si may also help to achieve the right levels of oxygen and/or nitrogen in the component. In some embodiments, the powder or powder mixture further comprises a certain content of % Cr+% V+% Ti+% Ta+% Si. In an embodiment, the powder or powder mixture comprises a certain content of % Moeq, a certain content of % C and a certain content % Cr+% V+% Ti+% Ta+% Si. In another embodiment, the powder or powder mixture comprises a certain content of % Moeq, a certain content of % Ceq and a certain content of % Cr+% V+% Ti+% Ta+% Si. Unless otherwise stated, the feature “certain content of % Cr+% V+% Ti+% Ta+% Si” is defined throughout the present document in the form of different alternative that are explained in detail below. In different embodiments, a certain content of % Cr+% V+% Ti+% Ta+% Si is less than 2.9 wt %, less than 1.9 wt %, less than 0.9 wt %, less than 0.4 wt %, less than 0.28 wt % and even less than 0.09 wt %. All the embodiments disclosed above can be combined among them in any combination, provided that they are not mutually exclusive, for example a steel powder where % Moeq is above 0.11 wt %, % C is below 0.98 wt %; and % Cr+% V+% Ti+% Ta+% Si is below 2.9 wt %; or for example a steel powder where % Moeq is below 14 wt %, % Ceq is above 0.11 wt % and % Cr+% V+% Ti+% Ta+% Si is below 1.9 wt %. In an embodiment, the above disclosed refers to the powder or powder mixture used to fill the mold. In an embodiment, the above disclosed refers to the powder or powder mixture used to form the component by MAM.

The inventor has surprisingly found that for some applications, particularly when the powder used is a steel powder or a powder mixture with the overall composition of a steel, the presence of a certain content of % C or % Ceq (% Ceq is as previously defined in this document) and a certain content of % Cr is advantageous to achieve the required mechanical properties. In an embodiment, the powder or powder mixture comprises a certain content of % C and a certain content of % Cr. In another embodiment, the powder or powder mixture comprises a certain content of % Ceq and a certain content of % Cr. Unless otherwise stated, the feature “certain content of % Cr” is defined throughout the present document in the form of different alternatives, that are explained in detail below. In different embodiments, a certain content of % Cr is less than 4.4 wt %, less than 3.9 wt %, less than 3.4 wt % and even less than 2.9 wt %. For certain applications, a certain content is preferred. In different embodiments, a certain content of % Cr is more than 2.6 wt %, more than 3.1 wt %, more than 3.6 wt % and even more than 4.1 wt %. All the embodiments disclosed above can be combined among them in any combination, provided that they are not mutually exclusive, for example a steel powder where % Cr is above 2.6 wt % and % C is below 0.98 wt %; or for example a steel powder where % Cr is below 4.4 wt % and % Ceq is above 0.11 wt %. For Certain applications, the presence of a certain content of % Mo+% V+% W may also help to achieve the required mechanical properties. In some embodiments, the powder or powder mixture further comprises a certain content of % Mo+% V+% W. In an embodiment, the powder or powder mixture comprises a certain content of % C, a certain content of % Cr and a certain content of % Mo+% V+% W. In another embodiment, the powder or powder mixture comprises a certain content of % Ceq, a certain content of % Cr and a certain content of % Mo+% V+% W. Unless otherwise stated, the feature “certain content of % Mo+% V+% W” is defined throughout the present document in the form of different alternatives, that are explained in detail below In different embodiments, a certain content of % Mo+% V+% W is more than 0.22 wt %, more than 0.52 wt % and even more than 1.1 wt %. For certain applications, excessively high contents should be avoided. In different embodiments, a certain content of % Mo+% V+% W is less than 4.8 wt %, less than 3.8 wt %, less than 2.8 wt % and even less than 1.8 wt %. All the embodiments disclosed above can be combined among them in any combination, provided that they are not mutually exclusive, for example a steel powder where % Cr is above 2.6 wt %, % C is below 0.98 wt % and % Mo+% V+% W is above 0.22 wt %; or for example a steel powder where % Cr is below 4.4 wt %, % Ceq is above 0.11 wt % and % Mo+% V+% W is below 4.8 wt %. In an embodiment, the above disclosed refers to the powder or powder mixture used to fill the mold. In an embodiment, the above disclosed refers to the powder or powder mixture used to form the component by MAM.

The inventor has surprisingly found that for some applications, particularly when the powder used is a steel powder or a powder mixture with the overall composition of a steel, the presence of a right content of % C and a right content of % Cr is advantageous to achieve the required mechanical properties. In an embodiment, the powder or powder mixture comprises a right content of % C and a right content of % Cr. Unless otherwise stated, the feature “right content of % C” is defined throughout the present document in the form of different alternatives, that are explained in detail below. In different embodiments, a right content of % C is more than 0.46 wt %, more than 0.65 wt %, more than 0.86 wt %, more than 1.05 wt % and even more than 1.25 wt %. For some applications, the content of % C should be controlled to avoid deteriorate mechanical properties. In different embodiments, a right content of % C is less than 2.9 wt %, less than 2.4 wt % and even less than 1.9 wt %. In an alternative embodiment, the above disclosed contents of % C refer to the content of % Ceq, being % Ceq=% C+0.86*% N+1.2*% B. Unless otherwise stated, the feature “right content of % Cr” is defined throughout the present document in the form of different alternatives, that are explained in detail below. In different embodiments, a right content of % Cr is less than 9.4 wt %, less than 8.9 wt %, less than 8.4 wt %, less than 7.9 wt % and even less than 6.4 wt %. For certain applications, a certain content is preferred. In different embodiments, a right content of % Cr is more than 4.1 wt %, more than 4.6 wt %, more than 5.1 wt %, more than 5.6 wt % and even more than 6.1 wt %. In an embodiment, the powder or powder mixture comprises a right content of % Ceq and a right content of % Cr. All the embodiments disclosed above can be combined among them in any combination, provided that they are not mutually exclusive, for example a steel powder where % Cr is more than 4.1 wt % and % C is less than 2.9 wt %; or for example a steel powder where % Cr is below 9.4 wt % and % Ceq is above 0.46 wt %. For Certain applications, the presence of a certain content of % Mo+% V+% W+% Ta may also help to achieve the required mechanical properties. In an embodiment, the powder or powder mixture comprises a right content of % C, a right content of % Cr and a certain content of % Mo+% V+% W+% Ta. In another embodiment, the powder or powder mixture comprises a right content of % C, a right content of % Cr and a certain content of % Mo+% V+% W+% Ta. Unless otherwise stated, the feature “certain content % Mo+% V+% W+% Ta” is defined throughout the present document in the form of different alternatives, that are explained in detail below. In different embodiments, a certain content % Mo+% V+% W+% Ta is more than 0.6 wt %, more than 1.2 wt %, more than 2.1 wt %, more than 2.6 wt %, more than 3.1 wt % and even more than 4.1 wt %. For certain applications, excessively high contents should be avoided. In different embodiments, a certain content of % Mo+% V+% W+% Ta is less than 19.9 wt %, less than 14.9 wt % and even less than 9.9 wt %. All the embodiments disclosed above can be combined among them in any combination, provided that they are not mutually exclusive, for example a steel powder where % Cr is above 4.1 wt %, % C is below 2.9 wt % and % Mo+% V+% W+% Ta is above 0.6 wt %; or for example a steel powder where % Cr is below 9.4 wt %, % Ceq is above 0.46 wt % and % Mo+% V+% W+% Ta is below 19.9 wt %. The inventor has surprisingly found that for some applications, when the powder is a stainless steel powder or a powder mixture with the overall composition of a stainless steel, the presence of high chromium contents is preferred. In an embodiment, the % Cr content in the powder or powder mixture is above 10.6 wt %. For certain applications, the % Cr should be kept below a certain value. In an embodiment, the % Cr content in the powder or powder mixture is below 49 wt %. The inventor has surprisingly found that for some applications, when the powder is a stainless steel powder or a powder mixture with the overall composition of a stainless steel, a chromium content above 10.6 wt % is particularly advantageous. In an embodiment, the % Cr content in the stainless steel powder or the powder mixture with the overall composition of a steel is below 49 wt %. In an embodiment, the above disclosed refers to the powder or powder mixture used to fill the mold. In an embodiment, the above disclosed refers to the powder or powder mixture used to form the component by MAM.

In alternative embodiments, the combination of elements with the contents disclosed in the preceding paragraphs refers to the composition of at least one of the powders in the powder mixture instead to the overall composition of the powder mixture. In other alternative embodiments, the combination of elements with the contents disclosed in the preceding paragraphs refers to the composition of a relevant powder in the powder mixture, being the relevant powder as previously defined. In other alternative embodiments, the combination of elements with the contents disclosed in the preceding paragraphs refers to the composition of a critical powder (as previously defined). In other alternative embodiments, the combination of elements and the contents of such elements as disclosed in the preceding paragraphs refers to the composition of the manufactured component.

One extremely surprising observation has been made by the inventor, namely for the same level of oxygen and/or nitrogen in the material of the final component, for some applications, noticeable better thermo-mechanical properties can be attained when the starting powder, or at least the powder prior to the fixing step has a high oxygen and/or nitrogen content. This seems to find a limit for certain values of oxygen and/or nitrogen where surpassing them leads to exactly the contrary effect. For some applications, the apparent density and in some instances also the non-metallic voids seem to play an important role in this effect. For some applications, the nature of the atmosphere used during the fixing step also seems to play a role. In several applications, a particular change in the apparent density during the fixing step also seems to play a role (following the teachings of this document, this change, in particular the apparent density, can be easily tailored by a specialist, and often can be attained in more than one way, providing the opportunity to accommodate or optimize some other relevant aspects). In an embodiment, the above disclosed refers to the powder or powder mixture used to fill the mold. In an embodiment, the above disclosed refers to the powder or powder mixture used to form the component by MAM.

Surprisingly, the inventor has found that components with good mechanical properties and high levels of performance can be achieved when the powder or the powder mixture employed has a proper oxygen (% O) content. Unless otherwise stated, the feature “proper oxygen content” is defined throughout the present document in the form of different alternatives that are explained in detail below. In different embodiments, a proper oxygen content is an oxygen content of more than 250 ppm, of more than 410 ppm, of more than 620 ppm, of more than 1100 ppm, of more than 1550 ppm and even of more than 2100 ppm. All expressed in wt %. For some applications, at least some powders are selected with a high but not extremely high oxygen content. In different embodiments, a proper oxygen content is an oxygen content of more than 2550 ppm, of more than 4500 ppm, of more than 5100 ppm and even of more than 6100 ppm. All expressed in wt %. For some applications, an excessive content of oxygen is detrimental to mechanical properties of the manufactured component. In different embodiments, a proper oxygen content is an oxygen content of less than 48000 ppm, of less than 19000 ppm, of less than 14000 ppm and even of less than 9900 ppm. All expressed in wt %. For some applications, lower contents are preferred. In different embodiments, a proper oxygen content is an oxygen content of less than 9000 ppm, of less than 6900 ppm, of less than 4900 ppm, of less than 2900 ppm and even of less than 900 ppm. All expressed in wt %. In an embodiment, the powder has a proper oxygen content. In another embodiment, the powder mixture comprises at least one powder with a proper oxygen content. In another embodiment, the powder mixture comprises at least two powders with a proper oxygen content. In another embodiment, the powder mixture comprises at least three powders with a proper oxygen content. In another embodiment, the powder mixture has a proper oxygen content. In some embodiments, it is particularly advantageous when the powder provided (or at least one of the powders in the powder mixture provided) is a powder obtained by water atomization with a proper oxygen content (as previously defined). Alternatively, in some embodiments, it is particularly advantageous when the powder provided (or at least one of the powders in the powder mixture provided) is a powder obtained by oxide reduction with a proper oxygen content (as previously defined). As previously disclosed, for some applications, the levels of nitrogen (% N) in the powder or powder mixture provided (starting powder) are very relevant. The inventor has found that components with good mechanical properties and high levels of performance can be achieved when the powder or the powder mixture employed has a proper nitrogen (% N) content. Unless otherwise stated, the feature “proper nitrogen content” is defined throughout the present document in the form of different alternatives, that are explained in detail below. In different embodiments, a proper nitrogen content is a nitrogen content of more than 12 ppm, of more than 55 ppm, of more than 110 ppm and even of more than 220 ppm. For some applications, an excessive content of nitrogen should be avoided. In different embodiments, a proper nitrogen content is a nitrogen content of less than 9000 ppm, of less than 900 ppm, of less than 490 ppm, of less than 190 ppm and even of less than 90 ppm. In an embodiment, the powder is a powder with a proper nitrogen content. In another embodiment, the powder mixture comprises at least one powder with a proper nitrogen content. In another embodiment, the powder mixture comprises at least two powders with a proper nitrogen content. In another embodiment, the powder mixture comprises at least three powders with a proper nitrogen content. In another embodiment, the powder mixture has a proper nitrogen content. All the embodiments disclosed above can be combined among them in any combination, provided that they are not mutually exclusive, for example: in an embodiment, the nitrogen content in the powder is above 55 ppm and below 99000 ppm; or for example: in an embodiment, the oxygen content in the powder is above 6 ppm and below 99000 ppm; or for example: in an embodiment, the powder mixture comprises at least a powder with a nitrogen content of more than 12 ppm and less than 9000 ppm; or for example: in an embodiment, the powder mixture comprises at least a powder with an oxygen content of more than 250 ppm and less than 48000 ppm; or for example: in an embodiment, the oxygen content of the powder is above 250 ppm and below 9000 ppm. In an embodiment, the above disclosed refers to the powder or powder mixture used to fill the mold. In an embodiment, the above disclosed refers to the powder or powder mixture used to form the component by MAM.

For some applications, it has been found to be advantageous to admix a nitrogen comprising material in the powder o powder mixture. In an embodiment, a nitrogen comprising material is admixed in the powder or powder mixture. In an embodiment, the amount of nitrogen comprising material is selected in terms of total weight % of nitrogen in the manufactured component. In another embodiment, the amount of nitrogen comprising material is selected in terms of total weight % of nitrogen in at least one of the materials comprised in the manufactured component. In another embodiment, the amount of nitrogen comprising material is selected in terms of total weight % of nitrogen in the material after the mixing is made. In different embodiments, the amount of nitrogen comprising material is selected so as to have 0.02 wt % or more nitrogen, 0.12 wt % or more nitrogen, 0.22 wt % or more nitrogen, 0.41 wt % or more nitrogen, 0.52 wt % or more nitrogen, 0.76 wt % or more nitrogen, 1.1 wt % or more nitrogen and even 2.1 wt % or more nitrogen. For certain applications, excessively high contents should be avoided. In different embodiments, the amount of nitrogen comprising material is selected so as to have 3.9 wt % or less nitrogen, 2.9 wt % or less nitrogen, 1.9 wt % or less nitrogen, 1.4 wt % or less nitrogen, 0.9 wt % or less nitrogen, 0.69 wt % or less nitrogen and even 0.49 wt % or less nitrogen. For some applications, the use of a higher nitrogen content is preferred. In different embodiments, a higher nitrogen content means a content of at least 10% more, at least 15% more, at least 20% more, at least 50% more and even 200% more than the amounts disclosed above. In an embodiment, the nitrogen comprising material is a nitride and/or a mixture of nitrides. For some applications, the use of carbo-nitrides, chromium nitrides, iron nitrides, molybdenum nitrides, tungsten nitrides, vanadium nitrides, niobium nitrides, tantalum nitrides, titanium nitrides and/or mixtures thereof is advantageous. In an embodiment, the nitrogen comprising material is a carbo-nitride. In an embodiment, the nitrogen comprising material comprises a carbo-boro-oxo-nitride. In an embodiment, the nitrogen comprising material comprises a carbo-nitride. In an embodiment, the nitrogen comprising material comprises a carbo-boro-oxo-nitride where carbon, boron and/or oxygen can be missing. In an embodiment, the nitrogen comprising material comprises a carbo-boro-oxo-nitride where carbon, boron and/or oxygen can be missing which is stable under standard conditions. In an embodiment, the nitrogen comprising material comprises a carbo-boro-oxo-nitride where carbon, boron and/or oxygen can be missing which is stable at 800° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 900° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 1000° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 1100° C. under standard pressure in an argon atmosphere with 0.5 ppm oxygen. In an embodiment, the nitrogen comprising material comprises a carbo-boro-oxo-nitride where carbon, boron and/or oxygen can be missing and which also comprises % Cr. In an embodiment, the nitrogen comprising material comprises a chromium nitride which is stable under standard conditions. In an embodiment, the nitrogen comprising material comprises a chromium nitride which is stable at 800° C. under standard pressure in an argon atmosphere with 0.5 ppm oxygen. In an embodiment, the nitrogen comprising material comprises a chromium nitride which is stable at 900° C. under standard pressure in an argon atmosphere with 0.5 ppm oxygen. In an embodiment, the nitrogen comprising material comprises a chromium nitride which is stable at 1000° C. under standard pressure in an argon atmosphere with 0.5 ppm oxygen. In an embodiment, the nitrogen comprising material comprises a chromium nitride which is stable at 1100° C. under standard pressure in an argon atmosphere with 0.5 ppm oxygen. In an embodiment, the nitrogen comprising material comprises the right chromium nitride content. In different embodiments, the right chromium nitride content is 0.094 wt % or more, 0.94 wt % or more, 1.4 wt % or more, 1.9 wt % or more, 2.9 wt % or more, 4.3 wt % or more and even 5.6% or more. For certain applications, an excessive content of chromium nitride is detrimental. In different embodiments, the right chromium nitride content is 18.3 wt % or less, 13.6 wt % or less, 8.9 wt % or less, 6.6 wt % or less and even 4.2 wt % or less. In an embodiment, the nitrogen comprising material comprises a carbo-boro-oxo-nitride where carbon, boron and/or oxygen can be missing and which also comprises % Fe. In an embodiment, the nitrogen comprising material comprises an iron nitride which is stable under standard conditions. In an embodiment, the nitrogen comprising material comprises a carbo-boro-oxo-nitride where carbon, boron and/or oxygen can be missing and which also comprises % Mo. In an embodiment, the nitrogen comprising material comprises a molybdenum nitride which is stable under standard conditions. In an embodiment, the nitrogen comprising material comprises a carbo-boro-oxo-nitride where carbon, boron and/or oxygen can be missing and which also comprises % W. In an embodiment, the nitrogen comprising material comprises a tungsten nitride which is stable under standard conditions. In an embodiment, the nitrogen comprising material comprises a carbo-boro-oxo-nitride where carbon, boron and/or oxygen can be missing and which also comprises % V. In an embodiment, the nitrogen comprising material comprises a vanadium nitride which is stable under standard conditions. In an embodiment, the nitrogen comprising material comprises a carbo-boro-oxo-nitride where carbon, boron and/or oxygen can be missing and which also comprises % Nb. In an embodiment, the nitrogen comprising material comprises a niobium nitride which is stable under standard conditions. In an embodiment, the nitrogen comprising material comprises a carbo-boro-oxo-nitride where carbon, boron and/or oxygen can be missing and which also comprises % Ti. In an embodiment, the nitrogen comprising material comprises a titanium nitride which is stable under standard conditions. In an embodiment, the above disclosed refers to the powder or powder mixture used to fill the mold. In an embodiment, the above disclosed refers to the powder or powder mixture used to form the component by MAM.

For some applications, the technology employed to manufacture the mold is relevant. In some embodiments, the mold may be manufactured using any available technology, including any conventional polymer shaping technology, such as, but not limited to: injection molding, polymer injection molding (PIM) . . . . In an embodiment, the technology used to provide the mold is a polymer shaping technology. In an embodiment, the technology used to provide the mold is polymer injection molding (PIM). In an embodiment, the technology used to provide the mold comprises the use of an additive manufacturing (AM) technology. In an embodiment, the technology used to provide the mold is casting, dipping, brushing or spraying of the mold material on a model fabricated through an AM technology. In an embodiment, the technology used to provide the mold comprises an AM technology. In an embodiment, the technology used to provide the mold comprises casting, dipping, brushing or spraying of the mold material on a model fabricated through an AM technology. In an embodiment, the technology used to provide the mold comprises casting of the mold material on a model fabricated through an AM technology. In an embodiment, the technology used to provide the mold comprises dipping of the mold material on a model fabricated through an AM technology. In an embodiment, the technology used to provide the mold comprises brushing of the mold material on a model fabricated through an AM technology. In an embodiment, the technology used to provide the mold comprises spraying of the mold material on a model fabricated through an AM technology. In another embodiment, the technology used to provide the mold is casting, dipping, brushing or spraying of the mold material on a model fabricated through an AM technology. In another embodiment, the technology used to provide the mold is casting of the mold material on a model fabricated through an AM technology. In another embodiment, the technology used to provide the mold is dipping of the mold material on a model fabricated through an AM technology. In another embodiment, the technology used to provide the mold is brushing of the mold material on a model fabricated through an AM technology. In another embodiment, the technology used to provide the mold is spraying of the mold material on a model fabricated through an AM technology. In another embodiment, the technology used to provide the mold is an AM technology. In another embodiment, the technology used to provide the mold is an AM technology based on material extrusion (such as fused deposition modeling (FDM), fused filament fabrication (FFF), . . . ). In another embodiment, the technology used to provide the mold is an AM technology based on vat photo-polymerization (stereolithography (SLA), digital light processing (DLP), continuous digital light processing (CDLP), digital light synthesis (DLS), a technology based on continuous liquid interface production (CLIP), . . . ). In another embodiment, the technology used to provide the mold is SLA. In another embodiment, the technology used to provide the mold is DLP. In another embodiment, the technology used to provide the mold is CDLP. In another embodiment, the technology used to provide the mold is DIS. In another embodiment, the technology used to provide the mold is a technology based on CLIP. In another embodiment, the technology used to provide the mold is a DLS based on CLIP. In another embodiment, the technology used to provide the mold is an AM technology based on material jetting (material jetting (MJ), drop on demand (DOD), . . . ). In another embodiment, the technology used to provide the mold is MJ. In another embodiment, the technology used to provide the mold is DOD. In another embodiment, the technology used to provide the mold is an AM technology based on binder jetting (multi jet fusion (MJF), binder jetting (BJ), . . . ). In another embodiment, the technology used to provide the mold is MJF. In another embodiment, the technology used to provide the mold is BJ. In another embodiment, the technology used to provide the mold is an AM technology based on powder bed fusion (selective laser sintering (SLS), selective heat sintering (SHS), . . . ). In another embodiment, the technology used to provide the mold is SLS. In another embodiment, the technology used to provide the mold is SHS. In another embodiment, the technology used to provide the mold is an AM technology based on energy deposition (direct energy deposition (DeD), . . . ). In another embodiment, the technology used to provide the mold is DeD. For some applications, some heads of the technologies mentioned in this paragraph can be mounted on very large printers for BAAM. In another embodiment, the technology used to provide the mold is big area additive manufacturing (BAAM). In another embodiment, the technology used to provide the mold is chosen amongst vat photo-polymerization and powder bed fusion technologies. In another embodiment, the technology used to provide the mold is like vat photo-polymerization but with a thermal curing. In another embodiment, the technology used to provide the mold is an AM technique based on a red-ox reaction. In an embodiment, the AM technology used to fabricate the mold is selected from, but not limited to, SLS, MJ, MJF, BJ, DOD, FDM, FFF, SHS, DeD, BAAM. SLA, DLP, DLS, CDLP, a technology based on CLIP and/or combinations thereof. In another embodiment, the technology used to provide the mold is chosen amongst SLA, DLP, CDLP, MJ, MJF, BJ, DOD and SLS or similar concept technologies. In another embodiment, the technology used to provide the mold is chosen amongst any AM technology that does not require the usage of supports to manufacture complex geometries. In another embodiment, the technology used to provide the mold is chosen amongst MJ, BJ, MJF and SLS. In another embodiment, the technology used to provide the mold is chosen amongst MJ, MJF and SLS. In another embodiment, the technology used to provide the mold is chosen amongst MJF and SLS. In another embodiment, the technology used to provide the mold is chosen amongst any technology capable of printing a feature on the layer being built that is not in contact with the already built piece. In an embodiment, the AM system employed uses the same built material which has not been consolidated to provide support for floating features. In another embodiment, the AM system employed uses a particulate material which has not been fully consolidated to provide support for floating features. In another embodiment, the AM system employed uses a different material to the built material to provide support for floating features. In another embodiment, the AM system employed uses a different material to the built material to provide support for floating features and once the piece is built the support material can be eliminated without damaging the built piece. In some embodiments, the use of at least two different AM methods is preferred. For some applications it does not matter which fabrication technology is used to provide the mold.

The inventor has found that for some applications the organic material (such as, but not limited to, the polymer and/or polymeric material) used to manufacture the mold is not critical as long as the mold can provide the shape of the component to be manufactured. Different materials can be advantageously used to manufacture the mold. For some applications, the material used to fabricate the mold is of great importance. For some applications the mold may be manufactured with a material which does not contain any polymer. In an embodiment, the material used to manufacture the mold does not contain any polymer. In another embodiment, the material used to manufacture the mold is a material with a relevant difference in the viscosity when measured at 20° C. and at 250° C. In another embodiment, the material used to manufacture the mold is a material having a different viscosity at 20° C. and at 250° C. In another embodiment, the material used to manufacture the mold is a material having a viscosity at 250° C. which is half or loss times the viscosity at 20° C. In another embodiment, it is 10 times less. In another embodiment, it is 100 times less. In an embodiment, the mold comprises an organic material. In an embodiment, the mold comprises a polymer. In an embodiment, the mold comprises a polymeric material. In an embodiment, the mold comprises an elastomer. In an embodiment, the mold comprises viton. In an embodiment, the mold is made of a material comprising a polymeric material. In an embodiment, the mold is made of a material consisting of a polymeric material. In an embodiment, the polymeric material is a polymer. In an embodiment, the mold is made of an elastomer. In another embodiment, the mold is made of viton. In some embodiments, the polymeric material comprises at least two different polymers. Some applications benefit from the dimensional stability of thermosetting polymers. In another embodiment, the mold is made of a thermosetting polymer. In another embodiment, the mold is made of a phenolic resin (PF). In another embodiment, the mold is made of a ureic resin (UF). In another embodiment, the mold is made of a melamine resin (MF). In another embodiment, the mold is made of a polyester resin (UP). In another embodiment, the mold is made of an epoxy resin (EP). In another embodiment, the mold is made of a thermosetting polymer and manufactured with an AM technology based on vat photo-polymerization. In an embodiment, the mold comprises a thermosetting polymer. In an embodiment, the mold comprises PF. In an embodiment, the mold comprises UF. In an embodiment, the mold comprises MF. In an embodiment, the mold comprises UP. In an embodiment, the mold comprises EP. In an embodiment, the mold comprises a thermosetting polymer and is manufactured with an AM technology based on vat photo-polymerization. Many applications can benefit from the re-shapability of thermoplastic polymers. In an embodiment, the mold is made of a thermoplastic polymer. In another embodiment, the mold is made of polyphenylene sulfide (PPS). In another embodiment, the mold is made of ether ketone (PEEK). In an embodiment, the mold is made of polyimide (Pl). In another embodiment, the mold is made of a thermoplastic polymer and manufactured with an AM technology based on material jetting. In another embodiment, the mold is made of a thermoplastic polymer and manufactured with an AM technology based on powder bed fusion. Some applications can benefit from the superior dimensional accuracy of amorphous polymers (both thermosetting and thermoplastic). Some applications can benefit from the superior dimensional accuracy combined with re-shapability of amorphous thermoplastics. In an embodiment, the mold is made of an amorphous polymer. In another embodiment, the mold is made of an amorphous thermoplastic polymer. In another embodiment, the mold is made of polystyrene (PS). In another embodiment, the mold is made of a polystyrene copolymer. When not otherwise indicated in this document, the polymers encompass their copolymers. In another embodiment, the mold is made of polymethyl methacrylate. In another embodiment, the mold is made of a copolymer comprising acrylonitrile. In another embodiment, the mold is made of a copolymer comprising styrene. In another embodiment, the mold is made of acrylonitrile-butadiene-styrene (ABS). In another embodiment, the mold is made of styrene-acrylonitrile (SAN). In another embodiment, the mold is made of polycarbonate (PC). In another embodiment, the mold is made of polyphenylene oxide (PPO). In another embodiment, the mold is made of a vinylic polymer (vinyl and related polymers). In another embodiment, the mold is made of polyvinyl chloride (PVC). In another embodiment, the mold is made of an acrylic polymer. In another embodiment, the mold is made of a polymethylmethacrylate (PMMA). In an embodiment, the mold is made of polycaprolactone (PCL). In an embodiment, the mold is made of porous polycaprolactone (PCL). In another embodiment, the mold is made of a polyvinyl acetate (PVA). In another embodiment, the mold is made of a Kollidon VA64. In another embodiment, the mold is made of a Kollidon 12 PF. Several applications can benefit from the superior elongation of some semi-crystalline thermoplastics. In another embodiment, the mold is made of a semi-crystalline thermoplastic. In another embodiment, the mold is made of polybutylene terephthalate (PBT). In another embodiment, the mold is made of polyoxymethylene (POM). In another embodiment, the mold is made of polyethylene terephthalate (PET). Several applications can benefit from the more defined melting point of semi-crystalline thermoplastics. In an embodiment, the mold is made of a polyolefin polymer. In an embodiment, the mold is made of a polymer comprising ethylene monomers. In an embodiment, the mold is made of polyethylene (PE). In another embodiment, the mold is made of high density polyethylene (HDPE). In another embodiment, the mold is made of low density polyethylene (LDPE). In another embodiment, the mold is made of a polymer comprising propylene monomers. In another embodiment, the mold is made of polypropylene (PP). In another embodiment, the mold is made of a polymer comprising monomers linked by amide bonds. In another embodiment, the mold is made of polyamide (PA). In another embodiment, the mold is made of a PA11 family material. In another embodiment, the mold is made of a PA12 family material. In another embodiment, the mold is made of a PA12. In another embodiment, the mold is made of a PA6. In another embodiment, the mold is made of a PA6 family material. In another embodiment, the mold comprises a thermoplastic polymer. In an embodiment, the mold comprises PPS. In an embodiment, the mold comprises PEEK. In an embodiment, the mold comprises P1. In an embodiment, the mold comprises a thermoplastic polymer and is manufactured with an AM technology based on material jetting. In an embodiment, the mold comprises a thermoplastic polymer and is manufactured with an AM technology based on powder bed fusion. Some applications can benefit from the superior dimensional accuracy of amorphous polymers (both thermosetting and thermoplastic). Some applications can benefit from the superior dimensional accuracy combined with re-shapability of amorphous thermoplastics. In an embodiment, the mold comprises an amorphous polymer. In an embodiment, the mold comprises an amorphous thermoplastic polymer. In an embodiment, the mold comprises PS. In an embodiment, the mold comprises a polystyrene copolymer. In an embodiment, the mold comprises PCL. In an embodiment, the mold comprises porous PCL. In an embodiment, the mold comprises PVA. In an embodiment, the mold comprises Kollidon VA64. In an embodiment, the mold comprises Kollidon 12 PF. When not otherwise indicated in this document, the polymers encompass their copolymers. In an embodiment, the mold comprises a polymer comprising an aromatic group. In an embodiment, the mold comprises polymethyl methacrylate. In an embodiment, the mold comprises a copolymer comprising acrylonitrile. In an embodiment, the mold comprises a copolymer comprising styrene. In an embodiment, the mold comprises ABS. In an embodiment, the mold comprises SAN. In an embodiment, the mold comprises PC. In an embodiment, the mold comprises PPO. In an embodiment, the mold comprises a vinylic polymer (vinyl and related polymers). In an embodiment, the mold comprises PVC. In an embodiment, the mold comprises an acrylic polymer. In an embodiment, the mold comprises PMMA. In an embodiment, the mold comprises amorphous PP. In an embodiment, the mold comprises a semi-crystalline thermoplastic. In an embodiment, the mold comprises polybutylene PBT. In an embodiment, the mold comprises POM. In an embodiment, the mold comprises PET. In an embodiment, the mold comprises a thermoplastic polymer resin from the polyester family. In an embodiment, the mold comprises a polyolefin polymer. In an embodiment, the mold comprises a polymer comprising ethylene monomers. In an embodiment, the mold comprises PE. In an embodiment, the mold comprises HDPE. In an embodiment, the mold comprises LDPE. In an embodiment, the mold comprises a polymer comprising propylene monomers. In an embodiment, the mold comprises PP. In an embodiment, the mold comprises a polymer comprising monomers linked by amide bonds. In an embodiment, the mold comprises PA. In an embodiment, the mold comprises aliphatic polyamide. In an embodiment, the mold comprises nylon. In an embodiment, the mold comprises a PA11 family material. In an embodiment, the mold comprises a PA12 family material. In an embodiment, the mold comprises PA12. In an embodiment, the mold comprises PA6. In an embodiment, the mold comprises a PA6 family material. In an embodiment, the mold comprises a semi-crystalline thermoplastic polymer and is manufactured with an AM technology based on material jetting, binder jetting and/or Powder Bed Fusion. In an embodiment, the mold comprises a semi-crystalline thermoplastic polymer and is manufactured with an AM technology based on SLS. In an embodiment, the mold comprises a polyolefin based polymer and is manufactured with an AM technology based on SLS. In an embodiment, the mold comprises a polyamide based polymer and is manufactured with an AM technology based on SLS. In an embodiment, the mold comprises a PA12 type based polymer and is manufactured with an AM technology based on SLS. In an embodiment, the mold comprises a PP based polymer and is manufactured with an AM technology based on SLS. In an embodiment, the mold comprises a polyolefin based polymer and is manufactured with an AM technology based on MJF. In an embodiment, the mold comprises a polyamide based polymer and is manufactured with an AM technology based on MJF. In an embodiment, the mold comprises a PA12 type based polymer and is manufactured with an AM technology based on MJF. In an embodiment, the mold comprises a PP based polymer and is manufactured with an AM technology based on MJF. In an embodiment, the mold comprises a biodegradable polymer. In an embodiment, the mold comprises an agro polymer (biomass from agro resources). In an embodiment, the mold comprises a biodegradable polymer from microorganisms (like PHA, PHB, . . . ). In an embodiment, the mold comprises a biodegradable polymer from biotechnology (like polylactic acid, polyactides, . . . ). In an embodiment, the mold comprises a biodegradable polymer from petrochemical products (like polycaprolactones, PEA, aromatic polyesters, . . . ). In a set of embodiments, when in this paragraph (above and below this line) it is said that the mold comprises a certain type of polymer, it is meant that a relevant amount of the polymeric material of the mold is made with the referred material. In a set of embodiments, when in this paragraph it is said that the mold comprises a certain type of polymer, it is meant that a relevant amount of the polymeric material of the mold is made with the referred material or a related one. In different embodiments, a relevant amount of the polymeric material means 6% or more, 26% or more, 56% or more, 76% or more, 96% or more and even 100%. In an embodiment, these percentages are by volume. In an alternative embodiment, these percentages are by weight. For some applications, besides the fact that the mold comprises a semi-crystalline thermoplastic, it is important that the semi-crystalline thermoplastic is chosen to have the right melting temperature (Tm), as described below. Obviously, as happens in the rest of the document when not otherwise specified, the same applies for the configurations where the mentioned type of material (in this case a semi-crystalline thermoplastic) is the main material of the mold or the cases where the whole mold is built with such a material. In different embodiments, the right melting temperature is below 290° C., below 190° C., below 168° C., below 144° C., below 119° C. and even below 98° C. For some applications, too low of a melting point is not practicable without risk of distortion. In different embodiments, the right melting temperature is above 28° C., above 55° C., above 105° C., above 122° C. above 155° and even above 175° C. In an embodiment, the melting temperature of any polymer in the present document is measured according to ISO 11357-1/-3:2016. In an embodiment, the melting temperature of any polymer in the present document is measured applying a heating rate of 20° C./min. In an embodiment, the mold is made of a non-polar polymer. For some applications, besides the fact that the mold comprises a semi-crystalline thermoplastic, it is important that the semi-crystalline thermoplastic is chosen to have the right crystallinity level. In different embodiments, the right crystallinity level means a crystallinity above 12%, above 32%, above 52%, 76%, 82% and even above 96%. In an embodiment, the values of crystallinity disclosed above are measured using X-ray diffraction (XRD) technique. In an alternative embodiment, the values of crystallinity disclosed above are obtained by differential scanning calorimetry (DSC). In an embodiment, the crystallinity is measured applying a heating rate of 10° C./min. For some applications, besides the fact that the mold comprises a polymer, it is important that the polymer is chosen to have the right molecular weight. In an embodiment, the material of the mold comprises polymeric material and a relevant part of it has a large enough molecular weight. Unless otherwise stated, the feature “relevant part” is defined throughout the present document in the form of different alternatives, that are explained in detail below. In different embodiments, a relevant part is 16% or more, 36% or more, 56% or more, 76% or more, 86% or more, 96% or more and even 100%. In an embodiment, above disclosed percentages are by volume. In an alternative embodiment, above disclosed percentages are by weight. In different embodiments, a large enough molecular weight is 8500 or more, 12000 or more, 45000 or more, 65000 or more, 85000 or more, 105000 or more and even 285000 or more. Some applications, contrary to what would result intuitively do not benefit from a large molecular weight. In a set of embodiments, the molecular weight for the majority of the polymeric phase of the material of the mold is kept at low enough molecular weights. In different embodiments, the majority refers to 55% or more, to 66% or more, to 78% or more, to 86% or more, to 96% or more and even to 100%. In an embodiment, the above disclosed percentages are by volume. In an alternative embodiment, these percentages are by weight. In different embodiments, a low enough molecular weight is 4900000 or less, 900000 or less, 190000 or less, 90000 or less and even 74000 or less. For some applications, besides the fact that the mold comprises a polymer, it is important that the polymer is chosen to have the right heat deflection temperature (HDT). In an embodiment, the material of the mold comprises polymeric material and a relevant part (as defined above) of it has a low enough heat deflection temperature measured with a load of 1.82 MPa (hereinafter referred as 1.82 MPa HDT). In different embodiments, low enough means 380° C. or less, 280° C. or less, 190° C. or less, 148° C. or less. In another embodiment, low enough means 118° C. or less, 98° C. or less and even 58° C. or less. In another embodiment, the material of the mold comprises polymeric material and a relevant part (as defined above) of it has a low enough heat deflection temperature measured with a load of 0.455 MPa (hereinafter referred as 0.455 MPa HDT). In different embodiments, low enough means 440° C. or less, 340° C. or less, 240° C. or less, 190° C. or less, 159° C. or less, 119° C. or less and even 98° C. or less. For many applications, an excessively low heat deflection temperature is not appropriate. In an embodiment, the material of the mold comprises polymeric material and a relevant part (as defined above) of it has a high enough 1.82 MPa HDT. In different embodiments, high enough means 32° C. or more, 52° C. or more, 72° C. or more, 106° C. or more, 132° C. or more, 152° C. or more, 204° C. or more and even 250° C. or more. In an embodiment, the material of the mold comprises polymeric material and a relevant part (as defined above) of it has a high enough 0.455 MPa HDT (as described above). In an embodiment, the values of HDT are determined according to ASTM D648-07 standard test method. In an alternative embodiment, HDT is determined according to ISO 75-1:2013 standard. In an embodiment, the HDT is determined with a heating rate of 50° C./h. In another alternative embodiment, the HDT reported for the closest material in the UL IDES Prospector Plastic Database at 29/01/2018 is used. Like with all other aspects of this invention, and when not otherwise indicated, some applications exist where the HDT of the material used to fabricate the mold does not matter. For some applications, besides the fact that the mold comprises a polymer, it is important that the polymer is chosen to have the right Vicat softening point. In different embodiments, the right Vicat softening point is 314° C. or less, 248° C. or less, 166° C. or less, 123° C. or less, 106° C. or less, 74° C. or less and even 56° C. or loss. For some applications, a mold comprising a material with a certain Vicat softening point is preferred. In different embodiments, the right Vicat softening point is 36° C. or more, 56° C. or more, 762° C. or more, 86° C. or more, 106° C. or more, 126° C. or more, 156° C. or more and even 216° C. or more. In an embodiment, the Vicat softening point is determined according to ISO 306 standard. In an embodiment, the Vicat softening point is determined with a heating rate of 50° C./h. In an embodiment, the Vicat softening point is determined with a load of 50N. In an alternative embodiment, the Vicat softening point is determined according to ASTM D1525 standard. In another alternative embodiment, the Vicat softening point is determined by the B50 method. In another alternative embodiment, the Vicat softening point is determined by the A120 method and 18° C. are substracted from the value measured. In another alternative embodiment, the Vicat softening point is determined in agreement with ISO 10350-1 standard using method B50. In another alternative embodiment, the Vicat hardness reported for the closest material in the UL IDES prospector plastic database at 29/01/2018 is used. For some applications, besides the fact that the mold comprises a polymer, it is important that the polymer is chosen to have the right classification in the Ensinger manual for engineering plastics. In an embodiment, the latest version available 21 Jan. 2018 is used. In another embodiment, the version 10/12 E9911075A011 GB is used. In an embodiment, a polymer with the classification of high-performance plastic is used. In an embodiment, a polymer with the classification of Engineering plastic is used. In an embodiment, a polymer with the classification of Standard plastic is used. It has been found for some applications that it is especially advantageous to use for at least portions of the mold, a material with an especially low softening point. In different embodiments, a material with an especially low softening point means a material with a melting temperature below 190° C., below 130° C., below 98° C., below 79° C., below 69° C. and even below 49° C. For some applications, a mold comprising a material with a certain melting temperature is preferred. In different embodiments, a material with a melting temperature above −20° C., above 28° C., above 42° C., above 52° C. and even above 62° C. is used. In an embodiment, the material is a polymer. In different embodiments, a material with a glass transition temperature (Tg) below 169° C., below 109° C., below 69° C., below 49° C., below 9° C., below −11° C., below −32° C. and even below −51° C. is used. For some applications, a mold comprising a material with a certain Tg is preferred. In different embodiments, a material with a Tg above −260° C., above −230° C., above −190° C. and even above −90° C. is used. In an embodiment, the glass transition temperature (Tg) of any polymer in the present document is measured by differential scanning calorimetry (DSC) according to ASTM D3418-12.

In an embodiment, the mold comprises a material with a low Tg as described in the preceding paragraph and in some stage before applying step i) of the pressure and/or temperature treatment (as described later in this document), the sealed and filled mold is undercooled. In different embodiments, the undercooling is made by holding the mold more than 10 minutes, more than 30 minutes, more than 2 hours and even more than 10 hours at a low temperature. In different embodiments, a low temperature for the undercooling is 19° C. or less, 9° C. or less, −1° C. or less, −11° C. or less and even −20° C. or less. For some applications, it is more convenient to adjust the undercooling low temperature to the softening point of the material of the mold with low softening point. In different embodiments, a low temperature for the undercooling is Tg+60° C. or less, Tg+50° C. or less, Tg+40° C. or less, Tg+20° C. or less and even Tg+10° C. or less. It has also been found that for some applications, an excessive undercooling is also negative leading to different shortcomings in different applications (as an example, breakage of fine details of the mold during steps i), ii) and/or iii) in the pressure and/or temperature treatment, as described later in this document). In different embodiments, the undercooling should be limited to a maximum temperature of −273° C., −140° C., −90° C., −50° C., Tg−50° C., Tg−20° C., Tg−10° C., Tg and even Tg+20° C. For some applications, it has been surprisingly found that when undercooling is used, then the maximum relevant temperature applied in the pressure and/or temperature treatment steps ii) and/or iii), as described later in this document, should be somewhat lower. In different embodiments, when undercooling is employed between steps ii) and/or iii) of the pressure and/or temperature treatment (as described later in this document), then the maximum relevant temperatures should be reduced in 18° C., in 10° C. and even in 8° C. In some embodiments, the above disclosed about undercooling is particularly interesting when the material used to manufacture the mold comprises PCL. In another embodiment, the above disclosed about undercooling is particularly interesting when the material used to manufacture the mold comprises porous PCL. In another embodiment, the above disclosed about undercooling is particularly interesting when the material used to manufacture the mold comprises PVA. In another embodiment, the above disclosed about undercooling is particularly interesting when the material used to manufacture the mold comprises Kollidon VA64 and even in some embodiments, the above disclosed about undercooling is particularly interesting when the material used to manufacture the mold comprises Kollidon 12 PF.

It has been found that in the case of using SLS technology for the obtaining of the molds it is interesting to use a novel polymeric powder based on ternary or superior order polyamides with low melting point. This could also be employed in other AM methods based on polymer powder. In an embodiment, a powder with a ternary polyamide copolymer is employed. In an embodiment, a powder with a quaternary polyamide copolymer is employed. In an embodiment, a powder with a superior order polyamide copolymer is employed. In different embodiments, a ternary polyamide copolymer of PA12/PA66/PA6 with a melting temperature below 169° C., below 159° C. below 149° C., below 144° C., below 139° C., below 129° C. and even below 109° C. is employed. For certain applications a certain melting temperature is preferred. In different embodiments, a ternary polyamide copolymer of PA12/PA66/PA6 with a melting temperature above 82° C. above 92° C., above 102° C. and even above 122° C. is employed. In different embodiments, the polyamide copolymer has 42% or more, 52% or more, 62% or more and even 66% or more PA12. In an embodiment, the copolymer polyamide comprises a dark color pigment. In an embodiment, the copolymer polyamide comprises a black color pigment. In an embodiment, the polyamide copolymer powder is obtained directly through precipitation. In different embodiments, the polyamide copolymer powder has a D50 of 12 microns or more, of 22 microns or more, of 32 microns or more and even of 52 microns or more. For certain applications, excessively high values of D50 should be avoided. In different embodiments, the polyamide copolymer powder has a D50 of 118 microns or less, of 98 microns or less, of 88 microns or less and even of 68 microns or less.

For some applications it is interesting to have reinforcement in at least some of the polymeric material comprised in the mold. In an embodiment, at least a relevant part (as previously defined) of the polymeric material comprised in the mold comprises a sufficient amount of reinforcement. In different embodiments, a sufficient amount of reinforcement is 2.2% or more, 6% or more, 12% or more, 22% or more, 42% or more, 52% or more and even 62% or more. For certain applications, excessive contents should be avoided. In different embodiments, a sufficient amount of reinforcement is 78% or less, 68% or less, 48% or less, 28% or less and even 18% or less. In an embodiment, the above disclosed percentages of reinforcement are by volume. In an alternative embodiment, the above disclosed percentages of reinforcement are by weight. In an embodiment, the reinforcement comprises inorganic fibres. In an embodiment, the reinforcement (or one of the reinforcements when more than one is employed) present in a sufficient amount are inorganic fibres. In an embodiment, the reinforcement comprises glass fibres. In an embodiment, the reinforcement present in a sufficient amount are glass fibres. In an embodiment, the reinforcement comprises carbon fibres. In an embodiment, the reinforcement present in a sufficient amount are carbon fibres. In an embodiment, the reinforcement comprises basalt fibres. In an embodiment, the reinforcement present in a sufficient amount are basalt fibres. In an embodiment, the reinforcement comprises asbestos fibres. In an embodiment, the reinforcement present in a sufficient amount are asbestos fibres. In an embodiment, the reinforcement comprises ceramic fibres. In an embodiment, the reinforcement present in a sufficient amount are ceramic fibres. In an embodiment, the ceramic fibres are at least 50% oxides. In an embodiment, the ceramic fibres are at least 50% carbides. In an embodiment, the ceramic fibres are at least 50% borides. In an embodiment, the ceramic fibres are at least 50% nitrides. In an embodiment, these percentages are by volume. In an alternative embodiment, these percentages are by weight. In an embodiment, the ceramic fibers comprise silicon carbide. In an embodiment, the reinforcement comprises inorganic fillers. In an embodiment, the reinforcement present in a sufficient amount are inorganic fillers. In an embodiment, the reinforcement comprises mineral fillers. In an embodiment, the reinforcement present in a sufficient amount are mineral fillers. In an embodiment, the reinforcement comprises organic fibres. In an embodiment, the reinforcement present in a sufficient amount are organic fibres. In an embodiment, the reinforcement comprises natural fibres. In an embodiment, the reinforcement present in a sufficient amount are natural fibres. For some applications it is very detrimental to have reinforcement in any relevant part of the polymeric material comprised in the mold. In an embodiment, the above disclosed refers to at least one of the reinforcements when more than one reinforcement is employed. In an embodiment, there is no reinforcement in any relevant part (as previously defined) of the polymeric material comprised in the mold. In different embodiments, all reinforcements are kept below 48%, below 28%, below 18%, below 8%, below 2% and even at 0%. In an embodiment, the above disclosed percentages of reinforcement are by volume. In an alternative embodiment, the above disclosed percentages of reinforcement are by weight. For some applications, besides the fact that the mold comprises a polymer, it is important that the polymer is chosen to have the right tensile strength at room temperature when characterized at the proper strain rate. In an embodiment, the mold comprises a polymer with the right tensile strength at room temperature when characterized at the proper strain rate. In different embodiments, the right tensile strength is 2 MPa or more, 6 MPa or more, 12 MPa or more, 26 MPa or more, 52 MPa or more and even 82 MPa or more. For some applications, tensile strength should not be too high. In different embodiments, the right tensile strength is 288 MPa or less, 248 MPa or less, 188 MPa or less and even 148 MPa or less. Unless otherwise stated, the feature “proper strain rate” is defined throughout the present document in the form of different alternatives, that are explained in detail below. In different embodiments, the proper strain rate is 2500 s⁻¹, 500 s⁻¹, 50 s⁻¹, 1.0 s⁻¹, 1·10⁻² s⁻¹ and even 1·10⁻³s⁻¹. For some applications, with special mention to several of the applications where steps ii) and ii) of the pressure and/or temperature treatment are skipped or greatly simplified, very surprisingly benefit from materials with intentional poor properties. In different embodiments, the right tensile strength is 99 MPa or les, 69 MPa or less, 49 MPa or less, 29 MPa or less, 19 MPa or less and even 9 MPa or less. In an embodiment, the values of tensile strength disclosed above are measured according to ASTM D638-14. In an alternative embodiment, the values of tensile strength disclosed above are measured according to ASTM D3039/D3039M-17. In some embodiments, the use of ASTM D3039/D3039M-17 is preferred for highly oriented and/or high tensile modulus reinforced polymers and ASTM D638-14 is preferred for unreinforced or randomly oriented or discontinuous polymers comprising low volume of reinforcements or having low tensile modulus. For some applications, the tensile modulus of the polymer has an influence. In an embodiment, the mold comprises a polymer with the right tensile modulus at room temperature when characterized at the proper strain rate (as defined above). In different embodiments, the right tensile modulus is 105 MPa or more, 505 MPa or more, 1005 MPa or more, is 1200 MPa or more, 1850 MPa or more and even 2505 MPa or more. For some applications, the tensile modulus should not be excessive. In different embodiments, the right tensile modulus is 5900 MPa or less, 3900 MPa or less, 2900 MPa or less, 2400 MPa or less, 1900 MPa or less and even 900 MPa or less. In an embodiment, the values of tensile modulus disclosed above are measured according to ASTM D638-14. In an alternative embodiment, the values of tensile modulus disclosed above are measured according to ASTM D3039/D3039M-17. In some embodiments, the use of ASTM D3039/D3039M-17 is preferred for highly oriented and/or high tensile modulus reinforced polymers and ASTM D638-14 is preferred for unreinforced or randomly oriented or discontinuous polymers comprising low volume of reinforcements or having low tensile modulus. For some applications not requiring excessive dimensional accuracy in the internal features or not even having any, it might be interesting to have a low flexural modulus. In an embodiment, the mold comprises a polymer with the right flexural modulus at room temperature when characterized at the proper strain rate (as defined above). In different embodiments, the right flexural modulus is 3900 MPa or less, 1900 MPa or less, 1400 MPa or less, 990 MPa or less and even 490 MPa or less. For some applications, the flexural modulus should not be too low. In different embodiments, the right flexural modulus is 120 MPa or more, 320 MPa or more and even 520 MPa or more. In an embodiment, the values of flexural modulus disclosed above are measured according to ASTM D790-17. The inventor has found with great interest, that for some applications what has a significant impact in the quality of the manufactured component especially in terms of internal microcracks is the strain rate susceptibility of the material employed for the mold. In different embodiments, the mold comprises a material which presents at least 6%, at least 16%, at least 26%, at least 56% and even at least 76% drop in the compressive true strength when measuring with a low strain rate in comparison to when measuring with a high strain rate. In different embodiments, the drop in compressive true strength is at least 2 MPa, at least 6 MPa, at least 12 MPa, at least 22 MPa and even at least 52 MPa. For some applications, particularly when not excessive accuracy is required in the internal features, it is interesting to employ materials with very little sensitivity to strain rate for the material of the mold. In different embodiments, the mold comprises a material which presents 89% or less, 48% or less, 18% or less and even 9% or less drop in the compressive true strength when measuring with a low strain rate in comparison to when measuring with a high strain rate. In an embodiment, compressive true strength refers to the compressive strength. In an embodiment, the compressive true strength at low and high strain rate is measured according to ASTM D695-15. In an alternative embodiment, the compressive true strength at low and high strain rate is measured according to ASTM D3410/D3410M-16. In an embodiment, the values of compressive true strength are at room temperature. For some applications, it is the tensile modulus strain sensitivity that matters. In different embodiments, the mold comprises a material which presents 6% or more, 12% or more, 16% or more, 22% or more and even 42% or more drop in the tensile modulus when measuring with a low strain rate in comparison to when measuring with a high strain rate. For applications, where the internal features accuracy is of great importance, it is often important to have a material for the mold with rather high insensitivity to strain rate. In different embodiments, the mold comprises a material which presents 72% or less, 49% or less, 19% or less and even 9% or less drop in the tensile modulus when measuring with a low strain rate in comparison to when measuring with a high strain rate. In an embodiment, the tensile modulus at low and high strain rate is measured according to ASTM 0638-14. In an alternative embodiment, the tensile modulus at low and high strain rate is measured according to ASTM D3039/D3039M-17. In some embodiments, the use of ASTM D3039/D3039M-17 is preferred for highly oriented and/or high tensile modulus reinforced polymers and ASTM D638-14 is preferred for unreinforced or randomly oriented or discontinuous polymers comprising low volume of reinforcements or having low tensile modulus. In different embodiments, a high strain rate is 6 s⁻¹ or more, 55⁻¹ or more, 550 s⁻¹ or more, 1050 s⁻¹ or more, 2050 s⁻¹ or more and even 2550 s⁻¹ or more. In different embodiments, a low strain rate is 9 s⁻¹ or less, 0.9 s⁻¹ or less, 0.9·10⁻² s⁻¹ or less, 0.9·10⁻³ s⁻¹ or less and even 0.9-10⁻⁴ s⁻¹ or less. For some applications, very surprisingly, it is advantageous to fabricate the mold in different pieces that are assembled together. In an embodiment, the mold is fabricated in different pieces that are assembled together. In an embodiment, the mold is fabricated by a significant amount of different pieces assembled together. Unless otherwise stated, the feature “significant amount” is defined throughout the present document in the form of different alternatives, that are explained in detail below. In different embodiments, a significant amount is 3 or more, 4 or more, 6 or more, 8 or more, 12 or more, 18 or more and even 22 or more. In an embodiment, at least one of the pieces that are assembled to fabricate the mold is provided with a guiding mechanism that fixes the orientation with respect of at least one of the pieces to which it is assembled. In an embodiment, a significant amount (as defined above) of the pieces that are assembled to fabricate the mold comprise a guiding mechanism that fixes the orientation with respect to at least one of the pieces to which they are assembled (the reference piece to which the orientation is fixed might be a different one for each piece considered). In an embodiment, a significant amount (as defined above) of the pieces that are assembled to fabricate the mold comprise a guiding mechanism that fixes the orientation with respect to at least one single piece of the mold, that can be referred as reference piece (obviously, there can be more than one reference piece). In an embodiment, a significant amount (as defined above) of the pieces that are assembled to fabricate the mold comprise a fixing mechanism that keeps them attached to at least one of the pieces to which they are assembled. In an embodiment, a significant amount (as defined above) of the pieces that are assembled to fabricate the mold comprise a fixing mechanism that keeps them attached to at least one of the pieces to which they are assembled in a compliance anisotropic way, where the difference in compliance is significant for different loading directions of the piece once the mold is assembled. In different embodiments, a significant compliance difference is 6% or more, 16% or more, 36% or more, 56% or more, 86% or more, 128% or more and even 302% or more. In an embodiment, the difference in compliance is measured as the largest value measured divided by the minimum value measured and expressed in percentage, the load applied being the same and the difference arising from the direction in which the load is applied. In different embodiments, the load used is 10 N, 100 N, 1000 N and even 10000 N. In different embodiments, the load used is the one causing a maximum stress of 1 MPa, of 10 MPa and even of 30 MPa in the direction of maximum stiffness. In an embodiment, fixation and guidance are made with one single mechanism for a significant amount (as defined above) of the pieces that are assembled to fabricate the mold. In an embodiment, at least two of the pieces that are assembled to fabricate the mold are manufactured with a different method. In an embodiment, at least two of the pieces that are assembled to fabricate the mold are manufactured with a different method, one of them being SLS. In an embodiment, at least two of the pieces that are assembled to fabricate the mold are manufactured with a different method, one of them being MJF. In an embodiment, at least three different manufacturing methods are employed to manufacture the pieces that are assembled to fabricate the mold. For some applications, it is very important how internal features are manufactured in the mold. In an embodiment, the mold comprises internal features which are solid and internal features which are void and which are connected to the exterior or to other void internal features which have connection to the exterior. In an embodiment, the mold comprises internal features which are void and which are connected to the exterior or to other void internal features which have connection to the exterior.

As has been described in the preceding paragraphs, very often the material of the mold is of polymeric nature, and thus soft and with little stiffness, it is therefore very surprising that the present method works and does so for complex geometry components (even including those with complex internal features), without cracks, with good dimensional accuracy. Intuitively one would expect the polymeric material to squeeze under the effect of the pressure, which is indeed what happens if the indications of the present document are not followed strictly. Unfortunately, different material systems and geometries require different sets of indications, and thus a comprehensive set of instructions is not simple to be provided, given the broad range of potential applications benefiting from the present invention.

For some applications, the powder or powder mixture employed to fill the mold is very important. As previously disclosed, the inventor has found that for some applications, the use of any of the powders or powder mixtures disclosed throughout this document is particularly advantageous. In an embodiment, the powder or powder mixture comprises a nitrogen austenitic steel powder. In an embodiment, the powder mixture comprises at least one nitrogen austenitic steel powder. For certain applications, the use of a nitrogen austenitic steel powder or a powder mixture having an overall composition corresponding to that of a nitrogen austenitic steel is preferred. In an embodiment, the powder is a nitrogen austenitic steel powder. In an embodiment, the powder mixture has a mean composition corresponding to that of a nitrogen austenitic steel. In some embodiments, the use of powder or powder mixtures according to the mixing strategies previously defined in this document. Accordingly, all the embodiments related to the powders or powders mixtures disclosed in the mixing strategies can be combined with the present method in any combination. In an embodiment, the powder mixture comprises at least a LP and SP powder (as previously defined). In an embodiment, the powder or powder mixture comprises a LP powder (as previously defined). In an embodiment, the powder or powder mixture comprises a SP powder (as previously defined). In an embodiment, the powder or powder mixture comprises at least a powder P1, P2. P3 and/or P4 (as previously defined). In some embodiments, the powders and/or powder mixtures disclosed in patent application number PCT/EP2019/075743, the contents of which are incorporated herein by reference in their entirety may be also advantageously used to fill the mold. For some applications, the morphology of the powder used to fill the mold is very important. In some embodiments, it is particularly advantageous to apply the method for the treatment of powder with microwaves (as previously defined) to the powders and powder mixtures used to fill the mold. In an embodiment, the method for the treatment of powder with microwaves (as previously defined) is applied to at least one of the powders in the powder mixture. In an embodiment, the method for the treatment of powder with microwaves (as previously defined) is applied to at least 2 of the powders in the powder mixture. In an embodiment, the method for the treatment of powder with microwaves (as previously defined) is applied to at least 3 of the powders in the powder mixture. In an embodiment, the method for the treatment of powder with microwaves (as previously defined) is applied to at least 4 of the powders in the powder mixture. In an embodiment, the method for the treatment of powder with microwaves (as previously defined) is applied to at least 5 of the powders in the powder mixture. In an embodiment, the method for the treatment of powder with microwaves (as previously defined) is applied to all the powders in the powder mixture.

For some applications, it is very important the filling density of the powder used to fill the mold, regardless of how this filling or apparent density is attained, while for other applications is the method employed to achieve the specified filling density what counts most. In an embodiment, the mold is filled at least partially with a balanced apparent density. In an embodiment, the mold is filled with a balanced apparent density. It has been found that for some applications, an excessively low apparent density makes it very difficult if not impossible to obtain complex geometries free of internal defects, even more so when the geometries encompass internal features. In different embodiments, a balanced apparent density is 52% or more, 62% or more, 66% or more, 72% or more, 74% or more, 76% or more, 78% or more and even 81% or more. It has been found that for some applications, an excessively high apparent density makes it very difficult if not impossible to obtain complex geometry components, with special mention to those of large size. In different embodiments, a balanced apparent density is 94% or less, 89% or less, 87% or less, 84% or less, 82% or less and even 79.5% or less. In an embodiment, the balanced apparent density is the apparent filling density. In an embodiment, the apparent filling density is the volume percentage of the mold which is occupied by the powder. In an embodiment, the above values of apparent density are at room temperature. In an embodiment, the apparent density is measured according to ASTM B329-06. It has been found that for some applications, the filling apparent density has to be well-adjusted with the maximum pressure applied to the mold in steps i), ii) and/or iii) of the pressure and/or temperature treatment (as described later in this document). In an embodiment, APPDEN*PADMP1<3√MaxPres<APPDEN*PADMP2, where PADM1 and PADM2 are parameters, APPDEN is the apparent filling density (in percentage and divided by 100) and Max-Pres is the maximum pressure applied in steps i), ii) and/or iii) of pressure and/or temperature treatment (as described later in this document). In an embodiment, Max-Pros is the maximum pressure in step i) of the pressure and/or temperature treatment. In an alternative embodiment, Max-Pres is the maximum pressure in step ii) of the pressure and/or temperature treatment (as described later in this document). In different embodiments, PADM1 is 5.0, 5.8, 6.0, 6.25, 6.6, 7.0, 7.2 and even 7.6. In different embodiments, PADM2 is 8.0, 8.8, 10.0, 10.6, 11.4, 12.1, 12.6 and even 13.6.

For some applications, it is important how the mixing of the material previous to the filling of the mold is effectuated. In an embodiment, different powders are blended together in a mixer. In an embodiment, different powders are mixed for the right time in a rotating container. In an embodiment, not all powders are mixed at the same time, but some are mixed first and others added at a later point in time into the rotating container. In an embodiment, the rotating container does not have a rotation movement but a complex repetitive movement. In an embodiment, the rotating container is a powder mixer. In another embodiment, the rotating container is a turbula powder mixer (or blender). In another embodiment, the rotating container is a V-type powder mixer (or blender). In another embodiment, the rotating container is a Y-type powder mixer (or blender). In another embodiment, the rotating container is a single-cone-type powder mixer (or blender). In another embodiment, the rotating container is a double-cone-type powder mixer (or blender). In an embodiment, the rotating container has internal features that move. In an embodiment, the rotating container is still and has internal features that move. In an embodiment, the rotating container is made of steel and has internal features that move. In an embodiment, the right time refers to the total mixing time for the powder or material that has been mixed the longest time. In an embodiment, the right time refers to the total mixing time for the powder or material that has been mixed in the rotating container for the longest time. In different embodiments, the right time is 30 seconds or more, 3 minutes or more, 15 minutes or more, 32 minutes or more, 65 minutes or more, 2 h or more, 6 h or more, 12 h or more and even 32 h or more. For certain applications, an excessive mixing time may be detrimental. In different embodiments, the right time is 2000 h or less, 200 h or less, 9 h or less, 2.5 h or less, 74 minutes or less, 54 minutes or less and even 28 minutes or less.

For some applications, it is important how the filling of the mold is effectuated. In an embodiment, the mold is vibrated during at least part of the filling with powder. In an embodiment, the filling of the mold comprises the pouring of the powder and all the actions until the mold is sealed. In an embodiment, the filling of the mold comprises a vibration step during the introduction of the powder in the mold and/or afterwards during the actions undertaken to settle the powder correctly in the mold. In an embodiment, the vibration process comprises a long enough vibration step at the right acceleration. In another embodiment, the time of a vibration step is the total time vibrating within the right acceleration values, even when there might be periods at other acceleration values or even without vibration in between (which are disregarded when adding up the time). In different embodiments, a long enough vibration step means 2 seconds or more, 11 seconds or more, 31 seconds or more, 62 seconds or more, 6 minutes or more, 12 minutes or more, 26 minutes or more and even 125 minutes or more. For some applications, an excessive vibration time is negative towards the obtaining of defect free components. In different embodiments, a long enough vibration time means less than 119 minutes, less than 58 minutes and even less than 29 minutes. In different embodiments, the right acceleration is 0.006 g or more, 0.012 g or more, 0.6 g or more, 1.2 g or more, 6 g or more, 11 g or more and even 60 g or more. For some applications, an excessive acceleration may be detrimental. In different embodiments, the right acceleration is 600 g or less, 90 g or less, 40 g or less, 19 g or less, 9 g or less, 4 g or less, 0.9 g or less and even 0.09 g or less. In an embodiment, g is the gravity of earth, 9.8 m/s². In an embodiment, the vibration process comprises a long enough vibration step (in the terms described above in the case of acceleration) at the right vibration frequency. In an embodiment, the time of the vibration step is the total time vibrating within the right vibration frequency values, even when there might be periods at other vibration frequency values or even without vibration in between (which are disregarded when adding up the time). In different embodiments, the right vibration frequency is 0.1 Hz or more, 1.2 Hz or more, 12 Hz or more, 26 Hz or more, 36 Hz or more, 56 Hz or more and even 102 Hz or more. For certain applications, excessively high frequencies may be detrimental. In different embodiments, the right vibration frequency is 390 Hz or less, 190 Hz or less, 90 Hz or less, 69 Hz or less, 49 Hz or less and even 39 Hz or less. In an embodiment, the vibration process comprises a long enough (in the terms described above in the case of acceleration) vibration step at the right amplitude. In an embodiment, the time of the vibration step is the total time vibrating within the right amplitude values, even when there might be periods at other amplitude values or even without vibration in between (which are disregarded when adding up the time). In an embodiment, the amplitude is the “peak-to-peak” amplitude. In different embodiments, the right amplitude is 0.006 mm or more, 0.016 mm or more, 0.06 mm or more, 0.12 mm or more, 0.6 mm or more, 6 mm or more and even 16 mm or more. In an embodiment, the acceleration is chosen as described above, then the vibration frequency is chosen according to the grain size (D50) of the smallest powder amongst all the relevant (as previously defined) ones: LLF*D50<vibration frequency<ULF*D50 and the amplitude is fixed according to acceleration=amplitude×(frequency)². In an embodiment, D50 of the smallest powder amongst all the relevant powders (as previously defined) in the mixture is the smallest D50 of the relevant powders (as previously defined) in the mixture. In different embodiments, LLF is 0.01, 0.1, 0.6, 1.0, 6 and even 10. In different embodiments, ULF is 19, 9, 7, 4 and even 2. In an embodiment, D50 refers to the particle size at which 50% of the sample's volume is comprised of smaller particles in the cumulative distribution of particle size. In an alternative embodiment, D50 refers to the particle size at which 50% of the sample's mass is comprised of smaller particles in the cumulative distribution of particle size. In an embodiment, the particle size is measured by laser diffraction according to ISO 13320-2009. In an embodiment, in the above formula the vibration frequency is in Hz. In an embodiment, in the above formula the D50 is in microns. The inventor has found that for some applications, it is very interesting to apply pressure to the powder within the mold when the powder is being vibrated. In an embodiment, the right mean pressure is applied to at least some of the powder in the mold. In an embodiment, the right mean pressure is applied to the powder in the mold. In an embodiment, the right mean pressure is applied to the relevant powders (as previously defined) in the mold. In an embodiment, the right mean pressure is applied to at least one relevant powder (as previously defined) in the mold. In an embodiment, the mean pressure is calculated as the force applied divided by the minimum cross-section orthogonal to the direction of the application of the force. In an embodiment, the mean pressure is calculated as the force applied divided by the mean cross-section orthogonal to the direction of the application of the force. In different embodiments, the right mean pressure is 0.1 MPa or more, 0.6 MPa or more, 1.1 MPa or more, 5.1 MPa or more, 10.4 MPa or more, 15 MPa or more, 22 MPa or more and even 52 MPa or more. For certain applications, the application of excessive pressure may be detrimental. In different embodiments, the right mean pressure is 190 MPa or less, 90 MPa or less, 49 MPa or less, 29 MPa or less, 19 MPa or less and even 9 MPa or less. In an embodiment, a lid is manufactured for the application of the pressure, fitting an open surface on the mold. In an embodiment, the pressure application lid has the same shape as the lid of the mold but is extruded through a longer path (at least double the thickness). In an embodiment, the pressure application lid is fabricated with an AM technique. In an embodiment, the pressure is applied with a mechanical system. In an embodiment, the pressure is applied with a servo-mechanical system. In an embodiment, the pressure is applied with a hydraulic system. In an embodiment, the application of pressure and the application of vibration coincide in some point of time.

The inventor has found that for some applications, the sealing of the mold may help to improve the mechanical properties of the manufactured component. In an embodiment, the step of filling the mold comprises sealing the mold after filling with the powder or powder mixture.

For some applications, it is very important to seal the mold in a way that no fluids can penetrate into the mold, even when high pressures are applied. In an embodiment, the mold is sealed by using a glue. In another embodiment, the mold is sealed by using a caulk. In another embodiment, the mold is sealed by using a heat source, melting the mold and its lid together. In another embodiment, the mold is sealed by using a heat source, melting the mold and its lid together and additional polymeric material is brought into the area to be joined. In an embodiment, the heat source is based on combustion. In another embodiment, the heat source is based on electric heating. The inventor has found that for some applications, it is very interesting to provide a mold with an extension which may be similar to a tube. In an embodiment the mold comprises an extension. In an embodiment, the material of the mold and its extension are polymeric. In an embodiment, the mold and the extension are manufactured with the same material. This extension can be used to fill the mold, and after filled, the mold can be vacuumed and sealed through the extension. In an embodiment, the mold is sealed around its extension. In an embodiment, the mold is filled through the extension. In an embodiment, the mold is vacuumed through its extension. In an embodiment, the mold is sealed around its extension. In an embodiment, the mold is sealed around its extension by using pressure. In another embodiment, the mold is sealed around its extension by using a heat source. In another embodiment, the mold is sealed around its extension by using a heat source melting the mold and its extension together. In another embodiment, the mold is sealed around its extension by using a caulk. In another embodiment, the mold is sealed around its extension by using a glue. In some embodiments, an additional polymeric material can be brought into the area to be joined. In an embodiment, the filled mold is sealed in a leak free way from any contact with any fluid outside the sealed mold. In an embodiment, the filled mold is sealed in a leak free way from any contact with any liquid outside the sealed mold. In an embodiment, the filled mold is sealed in a leak free way from any contact with any fluid outside the sealed mold, even when high pressures are applied. In this context, high pressures refer to pressures of 6 MPa or more, 56 MPa or more, 76 MPa or more, 106 MPa or more and even 166 MPa or more. In an embodiment, the filled mold is sealed in a leak free way from any contact with any fluid outside the sealed mold, even when very high pressures are applied. In this context very high pressures are pressures of 206 MPa or more, 266 MPa or more, 306 MPa or more, 506 MPa or more, 606 MPa or more and even 706 MPa or more. In an embodiment, the filled mold is sealed in a water-tight way. In another embodiment, the filled mold is sealed in a vapor-tight way. In another embodiment, the filled mold is sealed in an oil-tight way. In another embodiment, the filled mold is sealed in a gas-tight way. In another embodiment, the filled mold is sealed in an absolutely-tight way. In another embodiment, the filled mold is sealed in a bacteria-tight way. In another embodiment, the filled mold is sealed in a pox-virus-tight way. In another embodiment, the filled mold is sealed in a bacteriophages-virus-tight way. In another embodiment, the filled mold is sealed in a RNA-virus-tight way. In an embodiment, the definition of tightness is according to Cat. No. 199 79_VA.02 from Leybold GmbH. In an embodiment, leak rates and/or vacuum tightness is determined according to DIN-EN 1330-8. In an alternative embodiment, leak rates and/or vacuum tightness is determined according to DIN-EN 13185. In another alternative embodiment, leak rates and/or vacuum tightness is determined according to DIN-EN 1779. In an embodiment, the filled mold is sealed in a vacuum tight way with a low leak rate. In different embodiments, a low leak rate is 0.9 mbar·l/s or less, 0.08 mbar·l/s or less, 0.008 mbar·l/s or less, 0.0008 mbar·l/s or less, 0.00009 mbar·l/s or less and even 0.000009 mbar·l/s or less. Very surprisingly, the inventor has found that for some applications, an excessive vacuum tightness is counterproductive, and negatively affects the final mechanical properties attainable. In different embodiments, a low leak rate is 1.2·10⁻⁹ mbar·l/s or more, 1.2·10⁻⁷ mbar·l/s or more, 1.2·10⁻⁶ mbar·l/s or more, 1.2·10⁻⁵ mbar·l/s or more and even 1.2·10⁻⁴ mbar·l/s or more. In an embodiment, the low leak rate described in this document refers to the leaking quantity of substance (for example air when the environment is air, or water when the environment is water, oil, . . . ). In an embodiment, when the substance is a liquid, the leak rates described in mbar·l/s are multiplied by 5.27 and then expressed in mg/s. In an embodiment, the leak rates described in this document refer to helium standard leak rate as per definition in DIN EN 1330-8. In an alternative embodiment, the leak rates and/or vacuum tightness values are measured according to DIN-EN 13185:2001. In another alternative embodiment, the leak rates and/or vacuum tightness values are measured according to DIN-EN 1779:2011. In an alternative embodiment, the values provided for leak rates described in mbar·l/s should read mbar·l/s He Std. For certain applications, the use of a pressure transmitting container (like a polymeric film, a bag, a vacuumized bag, a conformal coating, a mold, etc.) covering the mold is advantageous. In an embodiment, an organic coating is applied to at least part of the filled mold. In an embodiment, the coating comprises a polymer. In an embodiment, the coating comprises an elastomer. In an embodiment, the coating comprises a rubbery material. In an embodiment, the coating comprises a rubber. In an embodiment, the coating comprises a latex derivative. In an embodiment, the coating comprises latex. In an embodiment, the coating comprises a natural rubber. In an embodiment, the coating comprises a synthetic elastomer. In an embodiment, the coating comprises a silicone derivative. In an embodiment, the coating comprises a silicone. In an embodiment, the coating comprises a fluoroelastomer. In an embodiment, the coating comprises a M-Class rubber material according to ASTM D-1418 definition. In an embodiment, the coating comprises an ethylene-propylene containing elastomer material. In an embodiment, the coating comprises a terpolymer containing ethylene elastomer material. In an embodiment, the coating comprises a terpolymer containing propylene elastomer material. In an embodiment, the coating comprises an EPDM material. In an embodiment, the coating comprises a FKM material according to ASTM definition (ASTM D1418-17). In an embodiment, the coating comprises a perfluoroelastomer (FFKM). In an embodiment, the coating comprises an EPDM derivative. In an embodiment, the coating comprises a FKM derivative. In an embodiment, the coating comprises a FFKM derivative. For some applications the working temperature of the coating is important. In an embodiment, the coating has a high enough maximum working temperature. In an embodiment, the maximum working temperature is the degradation temperature of the material. In an alternative embodiment, the maximum working temperature is the temperature where the material has lost 0.05% of weight. In another alternative embodiment, the maximum working temperature is the temperature where the material stops presenting a low leak rate in the terms described above. In another alternative embodiment, the maximum working temperature is according to the literature definition. In different embodiments, a high enough maximum working temperature is 52° C. or more, 82° C. or more, 102° C. or more, 152° C. or more, 202° C. or more, 252° C. or more and even 302° C. or more. In an embodiment, the coating comprises continuous layers. In an embodiment, the coating is composed of several layers. In an embodiment, the coating is composed of several layers of different materials. In an embodiment, the coating covers the whole mold. In an embodiment, the coating is applied as a liquid that dries out or cures. In an embodiment, the coating is applied as a paste that dries out or cures. In an embodiment, at least part of the coating is applied through dipping of the filled mold into the coating material. In an embodiment, at least part of the coating is applied through brushing of the filled mold with the coating material. In an embodiment, at least part of the coating is applied through spraying of the filled mold with the coating material. In an embodiment, at least part of the internal features of the mold which are not filled with powder and have voids (are not completely solid with the mold material) are coated. In an embodiment, all of the internal features of the mold which are not filled with powder and have voids (are not completely solid with the mold material) are coated. In an embodiment, at least part of the internal features which are connected to the exterior are coated. In an embodiment, all of the internal features which are connected to the exterior are coated. In an embodiment, when coating internal features which are connected to the exterior, special care is taken to make sure that those internal features remain connected to the exterior after the coating so that pressure can be applied on the walls of the interconnected internal features on the opposite side of the powder. In an embodiment, the coating is just a pre-fabricated container that is placed over the filled mold. In an embodiment, the coating is just a pre-fabricated container comprising an elastomeric material that is placed over the filled mold. In an embodiment, the coating is just a vacuum bag that is placed over the filled mold. In an embodiment, a system to make vacuum in the filled mold using the coating as a vacuum container is provided. In an embodiment, a system to make vacuum in the filled mold using the coating as a vacuum container followed by its sealing to retain a vacuum in the mold is provided. In different embodiments, the coating is used as a vacuum container and a vacuum of 790 mbar or higher, 490 mbar or higher, 90 mbar or higher, 40 mbar or higher and even 9 mbar or higher is made. For some applications, it is advantageous to have a controlled high vacuum level in the mold in the following method steps. In an embodiment, a controlled high vacuum is applied to the filled mold using the coating as a vacuum tight container. In different embodiments, a controlled high vacuum level is 0.9 mbar or less, 0.09 mbar or less, 0.04 mbar or less, 0.009 mbar or less, 0.0009 mbar or less and even 0.00009 mbar or less. For certain applications, an excessive vacuum may be detrimental. In different embodiments, a controlled high vacuum level is 10⁻¹⁰ mbar or more, 10⁻⁸ mbar or more, 10⁻⁶ mbar or more and even 10⁻⁴ mbar or more. In an embodiment, a polymeric fastener is used to seal the coating and keep at least some of the applied vacuum in the filled mold when step i) of the pressure and/or temperature treatment (as described later in this document) is applied. In an embodiment, a metallic fastener is used to seal the coating and keep at least some of the applied vacuum in the filled mold when step i) of the pressure and/or temperature treatment (as described later in this document) is applied. In different embodiments, some of the applied vacuum is 190 mbar or higher vacuum, 9 mbar or higher vacuum, 0.9 mbar or higher vacuum, 0.09 mbar or higher vacuum, 0.009 mbar or higher vacuum and even 0.0009 mbar or higher vacuum. In an embodiment, the vacuum is retained in the filled mold only in the areas filled with powder. In an embodiment, the vacuum is retained in the filled mold only in the areas connected to the areas filled with powder, and thus the void areas of the internal features are excluded.

For some applications, it is interesting to seal the filled mold directly or even the filled mold with the coating or even the filled mold with the coating where vacuum has been performed and then the coating sealed, with a polymeric film. For some applications, it is interesting to use a polymeric film with a low permeability to gases and vapours. In different embodiments, a low permeability to gases and vapours is 190000 ml/(m²·24 h·MPa) or less, 79000 ml/(m²·24 h·MPa) or less, 49000 ml/(m²·24 h·MPa) or less, 19000 ml/(m²·24 h·MPa) or less and even 9000 ml/(m²·24 h·MPa) or less, wherein ml stands for milliliters. For some applications, it is interesting to have an extra low permeability to gases. For some applications, it is interesting to use a polymeric film with a very low permeability to gases and vapours. In different embodiments, a very low permeability to gases and vapours is 1900 ml/(m²·24 h·MPa) or less, 990 m/(m²·24 h·MPa) or less, 490 m/(m²·24 h·MPa) or less, 290 ml/(m²·24 h·MPa) or less and even 94 ml/(m²·24 h·MPa) or less. In an embodiment, the permeability to vapors is measured in g/(m²·24 h) and then multiplied by 1000 and expressed in ml/(m²·24 h·MPa) to evaluate if it fits the low permeability and/or very low permeability to gases and vapours defined in the preceding lines. Surprisingly enough, some applications do not benefit from excessively low permeability of the film. In different embodiments, the permeability to gases and vapours of the film is 0.012 ml/(m²·24 h·MPa) or more, 0.12 ml/(m²·24 h·MPa) or more, 1.2 ml/(m²·24 h·MPa) or more, 12 ml/(m²24 h·MPa) or more, 56 ml/(m²·24 h·MPa) or more and even 220 ml/(m²·24 h·MPa) or more. In an embodiment, the low permeability and/or very low permeability to gases and vapours refers to carbon dioxide. In another embodiment, the low permeability and/or very low permeability to gases and vapours refers to oxygen. In another embodiment, the low permeability and/or very low permeability to gases and vapours refers to hydrogen. In another embodiment, the low permeability and/or very low permeability to gases and vapours refers to nitrogen. In another embodiment, the low permeability and/or very low permeability to gases and vapours refers to helium. In another embodiment, the low permeability and/or very low permeability to gases and vapours refers to water vapour. In different embodiments, the low permeability and/or very low permeability to gases and vapours refers to carbon dioxide, to oxygen, to hydrogen, to nitrogen, to helium and/or to water vapour. In an embodiment, permeability to gases is measured according to ASTM D-1434 (1988). In an alternative embodiment, the above disclosed values of permeability to gases are measured according to ASTM D-3985-17 for oxygen. In an embodiment, permeability to gases is measured at 75° F. In another alternative embodiment, the above disclosed values of permeability to vapours are measured according to ASTM E-96/E96M-16. In an embodiment, the polymeric film with a low permeability and/or very low permeability to gases and vapours comprises a polyester. In an embodiment, the polymeric film with a low permeability and/or very low permeability to gases and vapours comprises MYLAR. In an embodiment, the polymeric film with a low permeability and/or very low permeability to gases and vapours comprises a polyimide. In an embodiment, the polymeric film with a low permeability and/or very low permeability to gases and vapours comprises KAPTON. In an embodiment, the polymeric film with a low permeability and/or very low permeability to gases and vapours comprises a polyvinyl fluoride. In an embodiment, the polymeric film with a low permeability and/or very low permeability to gases and vapours comprises TEDLAR. In an embodiment, the polymeric film with a low permeability and/or very low permeability to gases and vapours comprises a polyethylene. In an embodiment, the polymeric film with a low permeability and/or very low permeability to gases and vapours comprises HDPE. In an embodiment, the polymeric film comprises PPS. In an embodiment, the polymeric film comprises PEEK. In an embodiment, the polymeric film comprises P1. In an embodiment, the polymeric film comprises an elastomer. In an embodiment, the polymeric film comprises viton. In an embodiment, the polymeric film comprises EPDM. In an embodiment, the polymeric film is made of such polymeric materials. The material of the polymeric film is not limited to the use of these materials, however. For some applications, the right thickness of the polymeric film is important. In an embodiment, a polymeric film with the right thickness is employed. In different embodiments, the right thickness is 2 microns or more, 22 microns or more, 52 microns or more, 102 microns or more, 202 microns or more and even 402 microns or more. For certain applications, excessive thicknesses may be detrimental. In different embodiments, the right film thickness is 9 mm or less, 4 mm or less, 0.9 mm or less, 0.4 mm or less and even 0.09 mm or less. For some applications the strength of the polymeric film is important. In different embodiments, the polymeric film is chosen with an ultimate tensile strength of 6 MPa or more, of 26 MPa or more, of 56 MPa or more, of 106 MPa or more, of 156 MPa or more and even of 206 MPa or more. In an embodiment, the ultimate tensile strength of the polymeric film is determined according to ASTM D-882-18. In an embodiment, the above disclosed values of ultimate tensile strength are at 75° F. For some applications the strength at 5% elongation of the polymeric film should not be excessive. In different embodiments, the polymeric film is chosen with a strength at 5% elongation of 1900 MPa or less, of 490 MPa or less, of 290 MPa or less, of 190 MPa or less, of 140 MPa or less and even of 98 MPa or less. In an embodiment, strength at 5% elongation of the film is determined according to ASTM D-882-18. In an embodiment, the above disclosed values of strength at 5% elongation of the film are at 75° F. For some applications the maximum working temperature of the film is of importance. In an embodiment, the film has a high enough maximum working temperature. In an embodiment, the maximum working temperature is the degradation temperature of the material. In an alternative embodiment, the maximum working temperature is the temperature where the material has lost 0.05% of weight. In an embodiment, the mass loss can be measured according to ASTM E1131-08. In an alternative embodiment, the mass loss can be measured by thermogravimetry. In different embodiments, degradation temperature refers to the temperature corresponding to a mass loss of the material of 10 wt %, of 20%, of 25 wt %, of 45 wt %, of wt % and even over 65 wt % obtained following test conditions of ASTM E1131-08. In different embodiments, the maximum working temperature is the temperature where the materials permeability to oxygen increases 6%, 26% and even 100%. In different embodiments, the maximum working temperature is the temperature where the material ultimate tensile strength is 80%, 50% and even 30% of the value at 75° F. In different embodiments, a high enough maximum working temperature is 52° C. or more, 822° C. or more, 102° C. or more, 152° C. or more, 202° C. or more, 252° C. or more and even 302° C. or more.

In an embodiment, the low permeability and/or very low permeability to gases and vapours polymeric film is sealed into a bag with one opening before usage. In an embodiment, the low permeability and/or very low permeability to gases and vapours polymeric film is sealed in a conformal shape to the filled mold. In an embodiment, the low permeability and/or very low permeability to gases and vapours polymeric film is sealed with an adhesive. In an embodiment, the low permeability and/or very low permeability to gases and vapours film is thermo-sealed. In an embodiment, the low permeability and/or very low permeability to gases and vapours film is sealed by using a glue. In an embodiment, the low permeability and/or very low permeability to gases and vapours polymeric film is sealed by using a heat source. In an embodiment, the heat source is based on combustion. In another embodiment, the heat source is based on electric heating. In another embodiment, the low permeability and/or very low permeability to gases and vapours polymeric film is sealed by using pressure. In another embodiment, the low permeability and/or very low permeability to gases and vapours polymeric film is sealed by using a caulk. In some embodiments, an additional polymeric material can be brought into the area to be joined. In an embodiment, the low permeability and/or very low permeability to gases and vapours polymeric film is evacuated previous to the final sealing.

In different embodiments, the polymeric film is used as a vacuum container and a vacuum of 890 mbar or higher, 790 mbar or higher, 490 mbar or higher, 140 mbar or higher, 90 mbar or higher is made. For some applications, it is advantageous to have a controlled high vacuum level in the mold in the following method steps. In an embodiment, a controlled high vacuum is applied to the filled mold using the polymeric film as a vacuum tight container. In an embodiment, the filled mold which has been vacuum sealed using the coating as a vacuum tight container, is evacuated as a package using the polymeric film as a vacuum tight container. In different embodiments, a controlled high vacuum level is 40 mbar or less, 4 mbar or less, 0.9 mbar or less, 0.4 mbar or less, 0.09 mbar or less and even 0.0009 mbar or less. For certain applications, excessive vacuum may be detrimental. In different embodiments, a controlled high vacuum level is 108 mbar or more, 106 mbar or more, 103 mbar or more and even 102 mbar or more. In an embodiment, the polymeric film is sealed after realizing the vacuum. In an embodiment, the polymeric film is thermally sealed after realizing the vacuum. In an embodiment, the polymeric film is sealed with a glue after realizing the vacuum. For some applications, it is not convenient that the vacuumized low permeability and/or very low permeability to gases and vapours polymeric film acts an impediment for pressure applied in at least one of steps i), ii) and/or iii) of the pressure and/or temperature treatment (as described later in this document) to reach the void internal features of the mold. In an embodiment, the vacuum sealing of the low permeability and/or very low permeability to gases and vapours polymeric film does not difficult pressure applied in at least one of steps i), ii) and/or iii) of the pressure and/or temperature treatment (as described later in this document) to reach the void internal features of the mold. In an embodiment, the vacuum sealing of the low permeability and/or very low permeability to gases and vapours film does not impede the pressure applied in at least one of steps i), ii) and/or iii) of the pressure and/or temperature treatment (as described later in this document) to reach the void internal features of the mold. In an embodiment, the mold void internal features are connected to the exterior as explained in another section of this document. In an embodiment, the connections to the exterior are extended. In an embodiment, the connections to the exterior are extended with a polymeric material. In an embodiment, the connections to the exterior are extended in a vacuum tight way. In an embodiment, the connections to the exterior are extended in a vacuum tight way with the help of a glue. In an embodiment, the connections to the exterior are extended in a vacuum tight way with the help of an epoxy comprising glue. In an embodiment, the polymeric film is sealed around the connection to the exterior and/or its extension. In an embodiment, the polymeric film is vacuumized and sealed around the connection to the exterior and/or its extension. In an embodiment, the polymeric film and the connection to the exterior and/or its extension are bond together. In an embodiment, the polymeric film and the connection to the exterior and/or its extension are bond together in a vacuum tight way. In an embodiment, the polymeric film and the connection to the exterior and/or its extension are bond together with a glue. In an embodiment, the polymeric film and the connection to the exterior and/or its extension are bond together with an epoxy comprising glue. In an embodiment, a hole is performed allowing pressure to flow through the connection to the exterior and/or its extension of the void internal features of the mold while not disturbing the vacuum in the polymeric film. In an embodiment, a hole is performed allowing pressure to flow through the connection to the exterior and/or its extension of the void internal features of the mold while not disturbing the vacuum in the coating. In an embodiment, the hole is made shortly before step i) of the pressure and/or temperature treatment (as described later in this document) is initiated. In different embodiments, shortly is less than 10 seconds, less than a minute, less than 9 minutes, less than 24 minutes, less than an hour, less than a week and even less than a month.

In an embodiment, at least one of the steps described above is repeated more than once. In an embodiment, more than one sealing with a polymeric film with a low and/or very low permeability to gases and vapours is performed.

In some particular embodiments, the sealing of the mold can be extremely simplified and reduced to the closing of the mold containing the powder or powder mixture. In an embodiment, the sealing of the mold consists in the closing of the filled mold with a lid. In an embodiment, the sealing of the mold does not require the application of vacuum. In an embodiment, in the sealing of the mold a coating is applied as described and is not exposed to vacuum. In an embodiment, in the sealing of the mold the mold is wrapped with a material comprising a polymer.

The inventor has found that for some embodiments, when the manufacturing method comprises the use of a mold, the application of a pressure and/or temperature treatment as described below may help to improve the mechanical properties of the manufactured component. The step of: forming the component applying pressure and/or temperature; is also referred throughout the present methods as the forming step.

As previously disclosed, for certain applications, the use of a pressure transmitting container (like a polymeric film, a bag, a vacuumized bag, a coating, a mold, etc.) is advantageous. In another embodiment, a pressure transmitting container is placed over the filled and sealed mold. In an embodiment, the pressure is applied to the pressure transmitting container. In an embodiment, the pressure is applied to the polymeric film. In an embodiment, the pressure is applied to the mold.

In some embodiments, the pressure employed in the pressure and/or temperature treatment may be relevant to the mechanical properties of the manufactured component. In different embodiments, the pressure applied in the pressure and/or temperature treatment is 6 MPa or more, 60 MPa or more, 110 MPa or more, 220 MPa or more, 340 MPa or more, 560 MPa or more, 860 MPa or more and even 1060 MPa or more. For some applications, the application of excessive pressure seems to deteriorate the mechanical properties of the manufactured component. In different embodiments, the pressure applied in the pressure and/or temperature treatment is 2100 MPa or less, 1600 MPa or less, 1200 MPa or less, 990 MPa or less, 790 MPa or less, 640 MPa or less, 590 MPa or less and even 390 MPa or less. In an embodiment, the pressure applied in the pressure and/or temperature treatment refers to the mean pressure applied in the pressure and/or temperature treatment. In an alternative embodiment, the pressure applied in the pressure and/or temperature treatment refers to the minimum pressure applied in the pressure and/or temperature treatment. In another alternative embodiment, the pressure applied in the pressure and/or temperature treatment refers to the mean pressure applied in the pressure and/or temperature treatment, wherein the mean pressure is calculated excluding any pressure which is applied for less than a critical time. For some applications, the maximum pressure applied in the pressure and/or temperature treatment may be relevant. In different embodiments, the maximum pressure in the pressure and/or temperature treatment is 105 MPa or more, 210 MPa or more, 310 MPa or more, 405 MPa or more, 640 MPa or more, 1260 MPa or more and even 2600 MPa or more. In different embodiments, the maximum pressure applied in the pressure and/or temperature treatment is 2100 MPa or less, 1200 MPa or less, 990 MPa or less, 790 MPa or less, 640 MPa or less, than 590 MPa or less, 490 MPa or less and even 390 MPa or less. Unless otherwise stated, the feature “critical time” is defined throughout the present document in the form of different alternatives that are explained in detail below. In different embodiments, a critical time is 50 seconds, 29 seconds, 14 seconds, 9 seconds and even 3 seconds. For some applications, the term “critical time” used throughout this document is defined in accordance with any of the embodiments described above. Accordingly, all the embodiments disclosed above can be combined among them and with any other embodiment disclosed in this document that relates to a “critical time” in any combination, provided that they are not mutually exclusive. In an embodiment, any pressure which is maintained less than a critical time (as previously defined) is not considered a maximum pressure. In an embodiment, the maximum pressure is applied for a relevant time. Unless otherwise stated, the feature “relevant time” is defined throughout the present document in the form of different alternatives that are explained in detail below. In different embodiments, a relevant time is at least 1 second, at least 4 seconds, at least 12 seconds, at least 19 seconds, at least 56 seconds, at least 4 min and even at least 6 minutes. For some applications, excessively long times are disadvantageous. In different embodiments, a relevant time is less than 60 minutes, less than 30 minutes, less than 24 minutes, less than 9 minutes, less than 1 minute, less than 24 seconds and even less than 9 seconds. All the embodiments disclosed above can be combined among them and with any other embodiment disclosed in this document that relates to a “relevant time” in any combination, provided that they are not mutually exclusive. In an embodiment, the pressure is applied in a continuous way. In an embodiment, the pressure is applied in a continuous way for a relevant time (as previously defined). In an embodiment, at least part of the pressure of the fluid is applied directly over the component. In an embodiment, the pressure of the fluid is applied directly over the component. In an embodiment, when the component comprises internal features, at least part of the pressure of the fluid is applied directly over the internal features. In an embodiment, when the component comprises internal features, the pressure of the fluid is applied directly over the internal features. In an embodiment, when the component comprises internal features, the pressure of the particle fluidized bed is applied directly over the internal features.

For some applications, the temperature applied in the pressure and/or temperature treatment may be relevant to the mechanical properties of the manufactured component. The inventor has found that for some applications, a certain relation between the melting temperature of the powder or powder mixture used to manufacture the component and the temperature involved in the pressure and/or temperature treatment may be advantageous. In different embodiments, the temperature applied in the pressure and/or temperature treatment is below 0.94*Tm, below 0.84*Tm, below 0.74*Tm, below 0.64*Tm, below 0.44*Tm, below 0.34*Tm, below 0.29*Tm and even below 0.24 Tm, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In another alternative embodiment, Tm refers to the melting temperature of a powder mixture (as previously defined). For some applications, when only one powder is used, Tm is the melting temperature of the powder. In this context, the temperatures disclosed above are in kelvin. For some applications, the temperature should be maintained above a certain value. In different embodiments, the temperature applied in the pressure and/or temperature treatment is above 0.16*Tm, above 0.19*Tm, above 0.26*Tm, above 0.3*Tm, above 0.45*Tm, above 0.61*Tm, above 0.69*Tm, above 0.74*Tm and even above 0.88*Tm, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In other alternative embodiments, Tm refers to the melting temperature of a powder mixture (as previously defined). For some applications, when only one metallic powder is used, Tm is the melting temperature of the metallic powder. In this context, the temperatures disclosed above are in kelvin. For some applications, it is better to define the temperature applied in the pressure and/or temperature treatment in absolute terms. In different embodiments, the temperature applied in the pressure and/or temperature treatment is above −14° C. above 9° C., above 31° C., above 48° C., above 86° C., above 110° C., above 156° C., above 210° C. above 270° C. and even above 310° C. For some applications, excessively high temperatures may be detrimental. In different embodiments, the temperature applied in the pressure and/or temperature treatment is below 649° C., below 440° C., below 298° C., below 249° C., below 149° C., below 90° C., below 49° C. and even below 29° C. In an embodiment, the temperature applied in the pressure and/or temperature treatment refers to the maximum temperature applied in the pressure and/or temperature treatment. In an alternative embodiment, the temperature applied in the pressure and/or temperature treatment refers to the mean temperature applied in the pressure and/or temperature treatment. In an embodiment, the mean temperature is calculated excluding any temperature which is maintained for less than a “critical time” (as previously defined). For some applications, the maximum temperature applied in the pressure and/or temperature treatment may be relevant to the mechanical properties of the manufactured component. In different embodiments, the maximum temperature applied in the pressure and/or temperature treatment is less than 995° C., less than 495° C., less than 245° C., less than 145° C. and even less than 85° C. For some applications, the maximum temperature applied should be above a certain value. In different embodiments, the maximum temperature applied in the pressure and/or temperature treatment is at least 26° C., at least 46° C., at least 76° C., at least 106° C., at least 260° C., at least 460° C., at least 600° C. and even at least 860° C. In an embodiment, the maximum temperature is maintained for a “relevant time” (as previously defined). In an embodiment, any temperature which is maintained for less than a “critical time” (as previously defined) is not considered a maximum temperature. For some applications, the minimum temperature applied may be relevant. In different embodiments, the minimum temperature applied in the pressure and/or temperature treatment is −29° C., −2° C., 9° C., 16° C., 26° C. and even 76° C. For some applications, the minimum temperature applied should be below a certain value. In different embodiments, the minimum temperature applied in the pressure and/or temperature treatment is less than 99° C., less than 49° C., less than 19° C., less than 1° C., less than −6° C. and even less than −26° C. For some applications, the minimum temperature applied should be above a certain value. In different embodiments, the minimum temperature in the pressure and/or temperature treatment is at least −51° C., at least −16° C., at least 0.1° C., at least 11° C., at least 26° C. at least 51° C. and even at least 91° C. In an embodiment, the minimum temperature is maintained for a “relevant time” (as previously defined). In an embodiment, any temperature which is maintained less than a “critical time” (as previously defined) is not considered a minimum temperature. In an embodiment, the temperature in the pressure and/or temperature treatment refers to the temperature of the pressurized fluid used to apply the pressure in the pressure and/or temperature treatment. The inventor has found that for some applications, significant variations in the temperature of the pressurized fluid during the pressure and/or temperature treatment are advantageous. In different embodiments, the maximum temperature gradient of the pressurized fluid during the pressure and/or temperature treatment is more than 6° C., more than 11° C., more than 16° C., more than 21° C., more than 55° C., more than 105° C. and even more than 145° C. For some applications, the maximum temperature gradient should be limited below a certain value. In different embodiments, the maximum temperature gradient of the pressurized fluid during the pressure and/or temperature treatment is less than 380° C., less than 290° C., less than 245° C., less than 149° C., less than 940° C., less than 49° C., less than 24.4° C., less than 23° C. and even less than 190° C. For some applications, the maximum temperature gradient should be maintained for a certain time. In different embodiments, a certain time is at least 1 second, at least 21 second and even at least 51 second. For some applications, the application of the maximum temperature gradient should be limited. In different embodiments, a certain time is less than 4 minutes, less than 1 minute, less than 39 seconds, less than 19 seconds. In an embodiment, the maximum pressure and temperature achieved in the pressure and/or temperature treatment takes place at the same time.

All the embodiments disclosed above can be combined among them in any combination, provided that they are not mutually exclusive.

For some applications, a minimum processing time is required. In different embodiments, the pressure and/or temperature treatment processing time is at least 1 min, at least 6 min, at least 25 min, at least 246 min, at least 410 min and even at least 1200 min. For some applications, excessive processing time seems to deteriorate the mechanical properties of the manufactured component. In different embodiments, the pressure and/or temperature treatment processing time is less than 119 hours, less than 47 hours, less than 23.9 hours, less than 12 hours, less than 2 hours, less than 54 minutes, less than 34 minutes, less than 24.9 minutes, less than 21 minutes, less than 14 minutes and even less than 8 minutes.

For some applications, the use of a pressure and/or temperature treatment comprising the steps disclosed below is advantageous. In an embodiment, the pressure and/or temperature treatment comprises the following steps:
step i) subjecting the mold to high pressure:
step ii) while keeping a high pressure level, raising the temperature of the mold;
step iii) while keeping a high enough temperature, releasing at least some of the to the mold applied pressure.

In some particular embodiments, steps ii) and ii) are optional and thus can be avoided. In an embodiment, step ii) is skipped. In an embodiment, step iii) is skipped.

In some applications, step i) is very critical. In some applications, it is important which means are used to apply the pressure, some are sensitive at the rate of pressure application and some at the maximum pressure level attained. The inventor was surprised at the far reaching consequences of some of those variables for some applications. On the other hand, some applications are rather insensitive as how pressure is applied and even the pressure level attained. In an embodiment, pressure is applied to the mold through a particle fluidized bed. In an embodiment, pressure is applied through a fluid. In an embodiment, pressure is applied through a fluid comprising water. In an embodiment, pressure is applied through a fluid comprising an organic material. In an embodiment, pressure is applied through a fluid comprising oil. In an embodiment, pressure is applied through a fluid comprising a vegetable oil. In an embodiment, pressure is applied through a fluid comprising a mineral oil. In an embodiment, pressure is applied through a liquid. In an embodiment, pressure is applied through a gas. In an embodiment, pressure is applied through a fluid comprising a liquid. In an embodiment, pressure is applied through a fluid comprising a gas. In an embodiment, subjecting the mold to high pressure means subjecting the mold to the right amount of maximum pressure. In an embodiment, the right amount of maximum pressure is applied to the filled and sealed mold. In an embodiment, the right amount of maximum pressure is applied for a relevant time (as previously defined) to the filled and sealed mold. In an embodiment, the right carbon potential of the furnace or pressure vessel atmosphere is determined by simulation in the same fashion as done by Torsten Holm and John Agren in chapter II. 15 (The carbon potential during the heat treatment of steel) of “The SGTE Casebook (Second edition)” Thermodinamics At Work from Woodhead Publishing. s explained, in some applications, steps ii) and/or iii) can be skipped. In some embodiments, higher pressures are normally required when skipping steps ii) and iii), but also when not skipping them, for some applications it is interesting to use even higher pressures to attain higher apparent density. In different embodiments, the right amount of maximum pressure is 410 MPa or more, 510 MPa or more, 601 MPa or more, 655 MPa or more and even 820 MPa or more. Surprisingly enough, in some applications an excessive amount of pressure in step i) leads to internal defects, even more so for complex and large geometries. In different embodiments, the right amount of maximum pressure is 1900 MPa or less, 900 MPa or less, 690 MPa or less, 490 MPa or less, 390 MPa or less and even 290 MPa or less. It is very surprising that such low levels of pressure, lead to sound final components for some of the powder mixtures of the present invention. For some applications, the way the pressure is applied has an incidence in the soundness of the components obtained. Unless otherwise stated, the feature “application of pressure in a stepwise manner” is defined throughout the present document in the form of different alternatives that are explained in detail below. In an embodiment, the pressure is applied in a stepwise manner. In different embodiments, the first step is done within the first 20%, the first 15%, the first 10% and even the first 5% of the right amount of maximum pressure. In different embodiments, the first step holding time is at least 2 seconds, at least 5 seconds, at least 15 seconds, at least 55 seconds and even at least 5 minutes. In different embodiments, during the first step holding time there is a variation on the applied pressure of ±5% or less, ±15% or less, ±55% or less and even ±75% or less. In an embodiment, there are at least two steps. In another embodiment, there are at least 3 steps. Some applications suffer when the pressure is applied too rapidly. In an embodiment, pressure is applied at a low enough rate in step i). Unless otherwise stated, the feature “low enough rate” is defined throughout the present document in the form of different alternatives, that are explained in detail below. In an embodiment, pressure is applied at a low enough rate at least within the initial stretch. In different embodiments, a low enough rate is 980 MPa/s or less, 98 MPa/s or less, 9.8 MPa/s or less, 0.98 MPa/s or less, 0.098 MPa/s or less and even 0.009 MPa/s or less. Some applications requiring a low rate cannot accept an excessively low rate. In different embodiments, a low enough rate is higher than 0.9 MPa/h, higher than 9 MPa/h, higher than 90 MPa/h, higher than 900 MPa/h and even higher than 9000 MPa/h. In different embodiments, the initial stretch is the first 5%, the first 10%, the first 25%, the first 55% and even the first 100% of the right amount of maximum pressure. In different embodiments, the initial stretch is the first 5 MPa, the first 10 MPa, the first 15 MPa, the first 25 MPa and even the first 55 MPa. Some applications in fact benefit from a fast pressure rate application, particularly in the first stretch. In an embodiment, pressure is applied at a high enough rate at least within the initial stretch (in the same sense as described above). In different embodiments, a high enough rate is 0.09 MPa/s or more, 0.9 MPa/s or more, 9 MPa/s or more and even 90 MPa/s or more. For some applications, it might be interesting to introduce the sealed and filled mold in the pressure application device, when the fluid used to apply the pressure is hot. In an embodiment, the sealed and filled mold is introduced in the pressure application device, when the fluid used to apply the pressure is hot. In another embodiment, the sealed and filled mold is introduced in the pressure application device, when the fluid used to apply the pressure is hot, but making sure at least part of the pressure is applied before the powder in the mold becomes hot. In another embodiment, the sealed and filled mold is introduced in the pressure application device, when the fluid used to apply the pressure is hot but making sure the pressure is applied in step i) before the powder in the mold becomes hot. In an embodiment, the pressure application device is any device capable to raising the applied pressure to the right amount of maximum pressure with the appropriate rate and capable of attaining the desired temperature in step ii). In an embodiment, the pressure application device is any device capable to raising the applied pressure to the right amount of maximum pressure. In different embodiments, the fluid being hot means it has a temperature of 35° C. or more, of 45° C. or more, of 55° C. or more, of 75° C. or more, of 105° C. or more and even of 155° C. or more. In different embodiments, the powder not becoming hot means it has a mean temperature of 145° C. or less, of 95° C. or less, of 45° C. or less and even of 35° C. or less. For some applications, a certain temperature is preferred. In different embodiments, the powder becoming hot means it has a mean temperature of more than 35° C., of more than 45° C., of more than 95° C. and even of more than 145° C.

In some applications it has been found that the filling apparent density has to be well-adjusted with the maximum pressure applied to the mold in step i) and the mean temperature of the powder. In an embodiment, the following rule applies at some point within step i): when MPID<LLMPI then: MAD+RFT1*MTI<LADT1 or MAD−RFP1*MPID<LPT1; when LLMPI s MPID<HLMPI then: MAD+RFT2*MTI<LADT2 or MAD−RFP2*MPID<LPT2; when HLMPI≤MPID then: MAD+RFT3*MTI<LADT3 or MAD+RFP3*MPID<LPT3; where: LLMPI, HLMPI, RFT1, LADT1, RFP1, LPT1, RFT2, LADT2, RFP2, LPT2, RFT3, LADT3, RFP3 and LPT3 are parameters: MPID=3√MaxPresD-5.84803548, and Max-PresD is the maximum pressure applied in step i); MAD=1/(AD)³ where AD is the mean apparent filling density of the powder in the mold; MTI=3√TP−6.83990379 and TP is the mean absolute temperature of the powder. In different embodiments, LLMPI is −1.367, −1.206, −0.916, −0.476 and even −0.308. In different embodiments, HLMPI is 0.366, 0.831, 1.458, 2.035, 2.539 and even 2.988. In different embodiments, RFT1 is 0.3, 0.8, 1.0, 2.3 and even 4.3. In different embodiments, LADT1 is 6.0, 3.5, 3.0, 2.8, 2.5, 2.0 and even 1.5. In different embodiments, RFP1 is 0.2, 0.9, 1.6, 2.2 and even 3.0. In different embodiments, LPT1 is 8.0, 5.0, 4.0, 3.0, 2.5 and even 2.0. In different embodiments, RFT2 is 0.3, 0.8, 1.0, 2.3, 3.3, 4.5 and even 6.3. In different embodiments, LADT2 is 5.5, 3.5, 3.25, 3.0, 2.8, 2.5, 2.0, 1.5 and even 1.0. In different embodiments, RFP2 is 0.2, 1.0, 1.6, 2.2, 3.0, 5.0 and even 7.0. In different embodiments, LPT2 is 7.4, 7.0, 5.0, 4.1, 3.5, 2.0, 1.0 and even 0.0. In different embodiments, RFT3 is 0.3, 0.8, 1.0, 2.3 and even 4.3. In different embodiments, LADT3 is 6.0, 3.5, 3.0, 2.8, 2.5, 2.0 and even 1.5. In different embodiments, RFP3 is 0.4, 1.1, 2.0, 3.2 and even 4.5. In different embodiments, LPT3 is 20.0, 16.5, 14.0, 10.0, 7.2, 6.0, 5.2 and even 3.0. In an embodiment, AD is the apparent filling density of the powder in the mold. In another embodiment, AD is the balanced apparent density. In an embodiment, TP is the mean temperature of the powder in step i). In another embodiment, TP is the maximum temperature of the powder in step i). In an embodiment, in the preceding rule the following values of MPID are not permitted: HLMPI S MPID. In an embodiment, in the preceding rules the following values of MPID are not permitted: MPID<LLMPI. In an embodiment, in the preceding rules the following values of MPID are not permitted: HLMPI S MPID<LLMPI.

The inventor has found that step i) is surprisingly capital for many applications. In fact, it is very counter-intuitive. One would expect to work much better a sequence where the pressure is applied after the temperature of the mold has been raised, so shifting steps ii) and i) but the inventor has found that doing so leads to components with internal defects, amongst many other reasons due to the flowing of the mold into the component itself, which can be on a first instance corrected by introducing a protective intermediate layer, at least for some simple geometries, but only prevents a few of the internal defects and no sound components can be attained. For some applications, and particularly when the components are small, this lack of soundness is sometimes not detrimental but of course for most applications pursued in the present invention it is unacceptably detrimental.

For some applications, step ii) is very important and the values of the relevant parameters have to be controlled properly. In an embodiment, the temperature of the mold is raised while keeping the right pressure level in step ii). In an embodiment, the temperature of the mold is raised by heating up the fluid that exerts the pressure. In an embodiment, the temperature is raised at least through radiation. In an embodiment, the temperature is raised at least through convection. In an embodiment, the temperature is raised at least through conduction. Unless otherwise stated, the feature “temperature of the mold” is defined throughout the pressure and/or temperature treatment in the form of different alternatives that are explained in detail below. In an embodiment, the temperature of the mold refers to the mean temperature of the mold provided. In an alternative embodiment, the temperature of the mold refers to the mean temperature of the powder contained in the mold. In another alternative embodiment, the temperature of the mold refers to the mean temperature of the fluid exerting pressure on the mold. In another alternative embodiment, the temperature of the mold refers to the mean temperature of the fluid exerting pressure on the mold and within 5 mm of the mold or mold sealing. In another alternative embodiment, the temperature of the mold refers to the mean temperature of the fluid exerting pressure on the mold and within 25 mm of the mold or mold sealing. In another alternative embodiment, the temperature of the mold refers to the temperature in the gravity center of the filled mold. In another alternative embodiment, the temperature of the mold refers to the temperature in the geometrical center of the filled mold. In different embodiments, the temperature of the mold is raised to 320 K or more, to 350 K or more, to 380 K or more, to 400 K or more, to 430 K or more and even to 480 K or more. For some applications it is important to assure the temperature of the mold is not excessive. In different embodiments, the temperature of the mold in step ii) is kept below 690K, below 660K, below 560K, below 510K, below 470K and even below 420K. For some applications, it is important to relate the temperature at which the mold is raised in step ii) to the material employed for the manufacture of the mold. In different embodiments, the temperature of the mold is raised to 0.6*1.82 MPa HDT of the mold material, or more, to 1.2*1.82 MPa HDT of the mold material, or more and even to 1.6*1.82 MPa HDT of the mold material, or more, being 1.82 MPa HDT as previously defined. In different embodiments, the temperature of the mold is raised to 0.6*0.455 MPa HDT of the mold material, or more, to 1.4*0.455 MPa HDT of the mold material, or more and even to 2.2*0.455 MPa HDT of the mold material, or more, being 0.455 MPa HDT as previously defined. In an embodiment, the calculations with HDT are done with temperatures expressed in Celsius degrees. In an alternative embodiment, the calculations with HDT are done with temperatures expressed in kelvin degrees. In an embodiment, for mold materials with more than one phase with different HDT, the lowest value of any relevant part (as previously defined) is taken. In an alternative embodiment, for mold materials with more than one phase with different HDT, the highest value of any relevant part (as previously defined) is taken. In another alternative embodiment, for mold materials with more than one phase with different HDT, the mean value of all relevant parts (as previously defined) is taken. In another alternative embodiment, for mold materials with more than one phase with different HDT, the mean value of all the parts constituting the majority (as previously defined) of the polymeric phase of the mold with lowest HDT is taken. In another alternative embodiment, for mold materials with more than one phase with different HDT, the mean value of all the parts constituting the majority (as previously defined) of the polymeric phase of the mold with highest HDT is taken. In this context, unless otherwise indicated, mean value refers to the weighted arithmetic mean, where the weights are the volume fractions. In alternative embodiments. HDT is replaced with the melting temperature for crystalline or semi-crystalline polymers. In different embodiments, the temperature of the mold in step ii) is kept below 0.73*Tm, below 0.48*Tm, below 0.38*Tm and even below 0.24*Tm, being Tm the melting temperature of the relevant powder (as previously defined) with the lowest melting point. In different embodiments, the temperature of the mold in step ii) is kept below 0.68*Tm, below 0.48*Tm, below 0.42*Tm, below 0.34*Tm and even below 0.24*Tm, being Tm the melting temperature of the relevant powder (as previously defined) with the highest melting point. In an embodiment, a relevant powder refers to a LP powder (as previously defined). In an embodiment, a relevant powder refers to a SP powder (as previously defined). In an embodiment, a relevant powder refers to a P1, P2, P3 and/or or P4 powder (as previously defined). In an embodiment, a relevant powder refers to any powder with low hardness (as previously defined). In an embodiment, a relevant powder refers to any powder with high hardness (as previously defined). For some applications, what is more relevant is the maximum relevant temperature achieved in step ii). In an embodiment, the maximum relevant temperature achieved in step ii) is 190° C. or less, 140° C. or less, 120° C. or less, 90° C. or less, Tm+50° C. or less, Tm+30° C. or less, Tm+10° C. or less, Tm or less and even Tm−20° C. or less. In an embodiment, Tm is the molting temperature of the powder or powder mixture used to form the component. In an alternative embodiment, Tm is the melting temperature of the material comprised in the mold. In another alternative embodiment, Tm is the melting temperature of a relevant part (as previously defined) of the mold. In an alternative embodiment, Tm is the melting temperature of the mold. Unless otherwise stated, the feature “relevant temperature” is defined throughout the present document in the form of different alternatives that are explained in detail below. In different embodiments, a relevant temperature refers to a temperature which is maintained more than 1 second, more than 20 seconds, more than 2 minutes, more than 11 minutes and even more than 1 h and 10 minutes. In some embodiments the maximum relevant temperature applied in step ii) is the maximum temperature applied in step ii).

As previously disclosed, the temperature of the mold is raised while keeping the right pressure level in step ii). In an embodiment, the right pressure level refers to the minimum pressure applied to the mold in step ii). In another embodiment, the right pressure level refers to the maximum pressure applied to the mold in step ii). In another embodiment, the right pressure level refers to any pressure applied to the mold in step ii). In another embodiment, the right pressure level refers to the mean pressure (time weighted) applied to the mold in step ii). In different embodiments, the right pressure level in step ii) is 0.5 MPa or more, 5.5 MPa or more, 10.5 MPa or more, 21 MPa or more, 105 MPa or more, 160 MPa or more and even 215 MPa or more. For some applications, it has been found that an excessive pressure in this step leads to undesirable distortions. In different embodiments, the right pressure level in step ii) is 1300 MPa or less, 990 MPa or less, 860 MPa or less, 790 MPa or less, 490 MPa or less, 390 MPa or less, 290 MPa or less, 190 MPa or less, 90 MPa or less and even 39 MPa or less. For some applications, it is interesting that a certain relation is kept between the maximum temperature of the mold and the right pressure level within step ii). In an embodiment, the right pressure level is kept between MSELP*[maximum temperature of the mold in step i) expressed in ° C.] and MSEHP*[maximum temperature of the mold in step i) expressed in ° C.]. In different embodiments, MSELP is 0.005, 0.02, 0.1, 0.25 and even 0.5. In different embodiments, MSEHP is 0.6. In another embodiment, MSEHP is 1.0, 2.0, 4.0 and even 7.0.

It is very surprising that the present invention works for the obtaining of intricate geometries and even more so when they comprise internal features for the reasons already exposed. Obviously, the process window is rather small and often geometry dependent. For complex geometries it has been found that often it is helpful for the obtaining of crack free components to apply a complex strategy when it comes to the achieving of the pressure and temperature levels indicated for steps i) and ii). It has been found that the way the pressure and temperature are applied, besides the actual levels, have a surprisingly strong influence both on the accuracy attainable in the final component and the lack of defects for some geometries. One such strategy consists of applying the pressure and temperature on a staircase fashion, where the levels are related to some intrinsic properties of at least one of the polymeric materials employed for the mold. In an embodiment, the following steps are used:
step A1: raising the pressure at a high enough level while keeping the temperature low enough;
step B1: raising the temperature to a certain level and keeping it in that level for a given time;
step C1: raising the pressure to a certain level and keeping it at that level for a given time;
step D1 (optional): repeat step B1, C1 or both one or more times at different levels of pressure and temperature;
step E1 (optional): make sure pressure and temperature are at the level defined for general step i) before proceeding with general step ii).

In different embodiments, the high enough pressure level in step A1 is 55 bar or more, 105 bar or more, 155 bar or more, 455 bar or more and even 655 bar or more. For some applications, the high pressure level should be limited. In different embodiments, the high enough pressure level in step A1 is 6400 bar or less, 2900 bar or less, 1900 bar or less, 1600 bar or less, 1200 bar or less, 990 bar or less and even 840 bar or less. In an embodiment, the low enough temperature level in step A1 is the critical temperature of the polymer of the mold or less. In another embodiment, the low enough temperature level in step A1 is 84% of the critical temperature of the polymer of the mold or less. In another embodiment, the low enough temperature level in step A1 is 75% of the critical temperature of the polymer of the mold or less. Unless otherwise stated, the feature “critical temperature” is defined throughout the present paragraph in the form of different alternatives that are explained in detail below. In an embodiment, the critical temperature of the polymer refers to the 1.82 MPa HDT (as previously defined). In another embodiment, the critical temperature of the polymer refers to the 0.455 MPa HDT (as previously defined). In another embodiment, the critical temperature of the polymer is the Tg of the polymer of the mold or less. In another embodiment, the critical temperature of the polymer is the Vicat temperature of the polymer of the mold or less. In an embodiment, the polymer of the mold—when more than one is present—is the one which has a higher volume fraction. In an alternative embodiment, the polymer of the mold— when more than one is present—is the one which has a higher weight fraction. In another alternative embodiment, the polymer of the mold —when more than one is present—is the weighted mean, using volume fraction as weight factors. In different embodiments, the upper level for the temperature in step B1 is 2.4 times, 1.4 times, 1 times and even 0.8 times the critical temperature. In different embodiments, the lower level for the temperature in step B1 is 0.2 times, 0.4 times the critical temperature, 0.8 times the critical temperature and even the critical temperature (as previously defined). In different embodiments, the time for which the temperature is kept at the desired level in step B1 is 3 minutes or more, 16 minutes or more, 32 minutes or more, 65 minutes or more and even 160 minutes or more. For some applications, excessively long times are disadvantageous. In different embodiments, the time for which the temperature is kept at the desired level in step B1 is lower than 27 hours, lower than 9 hours and even lower than 6 hours. In different embodiments, the upper level of pressure for step C1 is 6400 bar, 2900 bar, 2400 bar, 1900 bar and even 990 bar. In different embodiments, the lower level of pressure for step C1 is 310 bar or more, 610 bar or more, 1100 bar or more, 1600 bar or more and even 2100 bar or more. In different embodiments, the time for which the pressure is kept at the desired level in step B1 is 3 minutes or more, 16 minutes or more, 32 minutes or more, 65 minutes or more and even 160 minutes or more. For some applications, excessively long times are disadvantageous. In different embodiments, the time for which the pressure is kept at the desired level in step B1 is 26 hours or less, 12 hours or less, 8 hours or less, 5 hours or less and even 2 hours or less. For some applications, it has been found that is more recommendable to work with temperature values to define the steps in the staircase and not relate them to the intrinsic properties of the polymers used for the construction of the mold. In different embodiments, the low enough temperature level in step A1 is 190° C. or less, 140° C. or less, 90° C. or less and even 40° C. or less. In different embodiments, the upper level for the temperature in step B1 is 190° C., 159° C., 139° C. and even 119° C. In different embodiments, the lower level for the temperature in step B1 is 35° C., 45° C., 64° C., 84° C. and even 104° C.

In some applications, step iii) is very important to avoid internal defects in the manufactured components. In an embodiment, while keeping a high enough temperature, at least some of the to the mold applied pressure is released in step iii). In an embodiment, the temperature of the mold has the same meaning as in step ii). In different embodiments, a high enough temperature in step iii) means 320 K or more, 350 K or more, 380 K or more, 400 K or more, 500 K or more. For some applications, it is important to assure the temperature of the mold is not excessive. In different embodiments, the temperature of the mold in step iii) is kept below 690 K, below 660 K, below 560 K, below 510K, below 470 K and even below 420K. For some applications, it is important to relate the temperature at which the mold is kept in step iii) to the material employed for the manufacture of the mold. In an embodiment, the temperature of the mold is kept at 0.58*1.82 MPa HDT of the mold material or more, being 1.82 MPa HDT as previously defined. In another embodiment, the temperature of the mold is kept at 1.15*1.82 MPa HDT of the mold material or more being 1.82 MPa HDT as previously defined. In another embodiment, the temperature of the mold is kept at 1.55*1.82 MPa HDT of the mold material or more, being 1.82 MPa HDT as previously defined. In an embodiment, the temperature of the mold is kept at 0.6*0.455 MPa HDT of the mold material or more, being 0.455 MPa HDT as previously defined. In another embodiment, the temperature of the mold is kept at 1.4*0.455 MPa HDT of the mold material, or more, being 0.455 MPa HDT as previously defined. In another embodiment, the temperature of the mold is kept at 2.2*0.455 MPa HDT of the mold material or more, being 0.455 MPa HDT as previously defined. In an embodiment, in this aspect of the invention the calculations with HDT are done with temperatures expressed in Celsius degrees. In an embodiment, in this aspect of the invention the calculations with HDT are done with temperatures expressed in kelvin degrees. In an embodiment, for mold materials with more than one phase with different HDT, the lowest value of any relevant part (as previously defined) is taken. In an embodiment, for mold materials with more than one phase with different HDT, the highest value of any relevant part (as previously defined) is taken. In an embodiment, for mold materials with more than one phase with different HDT, the mean value of all relevant parts (as previously defined) is taken. In this aspect, mean value refers to the weighted arithmetic mean, where the weights are the volume fractions. In an embodiment, for mold materials with more than one phase with different HDT, the mean value of all the parts constituting the majority (as previously defined) of the polymeric phase of the mold with lowest HDT is taken. In an embodiment, for mold materials with more than one phase with different HDT, the mean value of all the parts constituting the majority (as previously defined) of the polymeric phase of the mold with highest HDT is taken. In an embodiment, HDT is determined according to ISO 75-1:2013 standard. In an alternative embodiment, the values of HDT are determined according to ASTM D648-07 standard test method. In an embodiment, the HDT is determined with a heating rate of 50° C./h. In another alternative embodiment, the HDT reported for the closest material in the UL IDES Prospector Plastic Database at 29/01/2018 is used. In an alternative embodiment, HDT is replaced with the melting temperature for crystalline or semi-crystalline polymers. In different embodiments, the temperature of the mold is kept below 0.73*Tm, below 0.48*Tm, below 0.38*Tm, below 0.24*Tm of the relevant powder (as previously defined) with the lowest melting point. In different embodiments, the temperature of the mold is kept below 0.68*Tm, below 0.48*Tm, below 0.42*Tm, below 0.34*Tm and even below 0.24*Tm of the relevant powder (as previously defined) with the highest melting point. In this context, Tm is the absolute melting temperature in kelvin. In an embodiment, a relevant powder refers to a LP powder (as previously defined). In an embodiment, a relevant powder refers to a SP powder (as previously defined). In an embodiment, a relevant powder refers to a P1, P2, P3 and/or or P4 powder (as previously defined). In an embodiment, a relevant powder refers to the hardest powder (as previously defined). In an embodiment, a relevant powder refers the softest powder (as previously defined). In an embodiment, a relevant powder refers to any powder with low hardness (as previously defined). In an embodiment, a relevant powder refers to any powder with high hardness (as previously defined). For some applications, what is more relevant is the maximum relevant temperature achieved in step iii). In an embodiment, the maximum relevant temperature (as previously defined) achieved in step iii) is 190° C. or less, 140° C. or less, 120° C. or less, 90° C. or less, Tm+50° C. or less, Tm+30° C. or less, Tm+10° C. or less, Tm or less and even Tm−20° C. or less. In an embodiment, Tm is the melting temperature of the powder or powder mixture used to form the component. In an embodiment. Tm is the melting temperature of the material comprised in the mold. In an alternative embodiment, Tm is the melting temperature of a relevant part (as previously defined) of the mold. In an alternative embodiment, Tm is the melting temperature of the mold. In some embodiments the maximum relevant temperature applied in step iii) is the maximum temperature applied in step iii). Unless otherwise stated, the feature “releasing at least some of the to the mold applied pressure in step iii) is defined throughout the present document in the form of different alternatives, that are explained in detail below. In different embodiments, releasing at least some of the to the mold applied pressure in step iii) means the pressure is lowered at least 5%, at least 10%, at least 20%, at least 40%, at least 60% and even at least 80% with respect to the highest value achieved in step i). In an embodiment, the percentage lowering of the pressure described in the previous lines refers not only to step i), but to any of steps i), ii) or iii) and thus the highest pressure achieved in any of them. In different embodiments, the pressure is lowered at least 0.6 MPa, at least 2 MPa, at least 10 MPa and even at least 60 MPa with respect to the highest value achieved in step i). For some applications, the pressure level achieved in step iii) is more important than the percentage reduction. In an embodiment, step iii) should read: while keeping a high enough temperature releasing at least some of to the mold applied pressure as to attain a pressure level below 390 MPa, below 90 MPa, below 19 MPa, below 9 MPa, below 4 MPa, below 0.4 MPa and even below 0.2 MPa. In an embodiment, all pressure is removed within step iii). Some applications are quite sensitive, particularly when it comes to internal defects of components, to the rates employed to release the pressure in step iii). In an embodiment, pressure is released at a low enough rate (as previously defined) at least within the final stretch. In an embodiment, the final stretch relates to the final 2%, the final 8%, the final 12%, the final 18% and even the final 48%. [taking as initial point the highest pressure applied to the mold in any of steps i), ii) or iii) and as final point the minimum pressure applied to the mold in step iii)]. In an embodiment, the final stretch relates to the final 0.1 MPa, the final 0.4 MPa, the final 0.9 MPa, the final 1.9 MPa and even the final 9 MPa [before reaching the minimum pressure applied to the mold in step iii)].

In an embodiment, after step iii) the pressure applied to the mold is completely released if it was not already done so in step iii). In an embodiment, after step iii) the pressure applied to the mold is completely released with the same caution regarding pressure release rates as described above for step iii). In an embodiment, after step iii) the pressure applied to the mold is completely released with the same fashion regarding pressure release steps as described above for step iii). In an embodiment, after step iii) the temperature of the mold is let drop to close to ambient values if it was not already done do in step iii). In an embodiment, after step iii) the of the mold is let drop to below 98° C. if it was not already done do in step iii). In another embodiment, after step iii) the temperature of the mold is let drop to below 48° C. if it was not already done do in step iii). In another embodiment, after step iii) the temperature of the mold is let drop to below 38° C. if it was not already done do in step iii). In an embodiment, after step iii) the temperature of the mold is let drop to a value convenient for carrying out the following method step if it was not already done do in step iii).

One should be surprised at the length of the process required for the present invention for steps i) to iii) which is much higher than that involved in other high-pressure moderate temperature (below 0.5*Tm and very often below 0.3*Tm) existing processes. In an embodiment, the total time of steps i) to iii) is higher than 22 minutes, higher than 190 minutes, higher than 410 minutes. For some applications, not very long times are preferred. In different embodiments, the total time of steps i) to iii) is lower than 47 hours, lower than 12 hours and even lower than 7 hours. Another singular overall characteristic of the process employed in steps i) to iii) is the large variations in temperature of the pressurized fluid taking place within the process. There are no WIP or CIP reported where significant variations in the temperature of the pressurized fluid take place during the process, a same WIP equipment can do two different jobs in the same day one job with a pressurized fluid temperature of 120° C. and the other job with a pressurized fluid temperature of 90° C. but the variation of temperature of the pressurized fluid within each one of those jobs is negligible. In different embodiments, the pressurized fluid maximum temperature gradient in steps i) to iii) is 25° C. or more, 55° C. or more, 105° C. or more. For some applications, excessively high temperature gradients should be avoided. In different embodiments, the pressurized fluid maximum temperature gradient in steps i) to iii) is 245° C. or less, 195° C. or less and even 145° C. or less.

In some instances, method steps ii) and iii) can be avoided, provided a very precise selection is made of the powder mixture used to fill the mold and the material used to manufacture the mold. In some instances, also special care has to be taken how the pressure is released, especially for the pressure releasing rate, after method step i) when method steps ii) and iii) are skipped. In some instances, also special care has to be taken to make sure void internal features from the mold receive the pressure applied to the mold in step i) when steps ii) and iii) are skipped. In an embodiment, steps ii) and iii) are not present. In an embodiment, steps ii) and iii) are limited to a release to at least some of the pressure applied to the mold in step i). In an embodiment, steps ii) and iii) are not present as described provided at least some of the conditions described in this paragraph are met. Several efforts have been employed in the past years to improve the properties of the materials obtained through AM. The inventor has found, that surprisingly in the aspect of the invention discussed in the present paragraph it is convenient to deliberately choose very poor performing materials or deliberately aim at poor mechanical properties and even voids and constructive defects when manufacturing the mold. In fact, when a high performant material is employed for the mold, for the aspect of the invention discussed in this paragraph, then even more care has to be taken to assure void internal features from the mold receive the pressure applied to the mold in step i), special care has to be taken how the pressure is released, proper filling rates have to be employed and/or special powder mixtures employed. In an embodiment, the method of the present invention comprises an additional step as disclosed below. In an embodiment, when steps ii) and iii) are skipped, at least one of the following has to take place:
I. the mold has a low tensile strength;
II, the mold has a high elastic modulus;
III, the mold has a significant drop in tensile strength when the strain rate is lowered;
IV, the filling of the mold is made with a high filling density:
V. the void internal features of the mold are allowed to have the applied pressure to the mold;
VI, the mixture has to have a large content of SP type powder;
VII. pressure is released as described for step iii).

The meaning and associated numerical values for the above described features are described elsewhere in this document. In different embodiments, a low tensile strength is 99 MPa or less, 49 MPa or less, 34 MPa or less, 29 MPa or less, 19 MPa or less, 14 MPa or less and even 9 MPa or less. In different embodiments, a high elastic modulus is more than 1.06 GPa, more than 1.12 GPa, more than 1.28 GPa, more than 1.46 GPa, more than 1.77 GPa and even more than 2.08 GPa. For some applications, the high elastic modulus should be limited. In different embodiments, a high elastic modulus is less than 6 GPa, less than 4 GPa, less than 3.2 GPa, less than 2.9 GPa and even less than 1.9 GPa. In an embodiment, the values of low tensile strength are measured with the proper strain rate. In different embodiments, the proper strain rate is 2500 s⁻¹, 500 s⁻¹, 50 s⁻¹, 1.0 s⁻¹, 1·10⁻² s⁻¹ and even 1·10³ s⁻¹. In an embodiment, the above disclosed values of tensile strength are at room temperature. In an embodiment, Point (II) is replaced by: the mold has a low elastic modulus. In different embodiments, a low elastic modulus is 0.96 GPa or less, 0.79 GPa or less, 0.74 GPa or less, 0.68 GPa or less, 0.48 GPa or less and even 0.24 GPa or less. In an embodiment, the above disclosed values of elastic modulus are at room temperature. In different embodiments, a significant drop in the tensile strength is 6% or more, 12% or more, 16% or more, 22% or more and even 42% or more. In different embodiments, the significant drop in tensile strength is produced when the strain rate is lowered at least 0.1%, at least 1.1%, at least 3.2%, at least 18%, at least 26% and even at least 41%. In different embodiments, the strain rate that is lowered is 2500 s⁻¹, 500 s⁻¹, 50 s⁻¹, 1.0 s⁻¹, 1·10⁻² s⁻¹ and even 1·10⁻³ s⁻¹. In different embodiments, a large content of a powder P2 is 1.2 wt % or more, 16 wt % or more, 22 wt % or more, 32 wt % or more, 36 wt % or more and even 42 wt % or more. In an embodiment, only I, II, III, V and VII are taken into account. In another embodiment, only I, III, IV and V are taken into account. In an embodiment, V is not taken into account. In an embodiment, VI is not taken into account. In an embodiment, IV is not taken into account. In an embodiment, III is not taken into account. In an embodiment, II is not taken into account. In an embodiment, I is not taken into account. In an embodiment, VII is not taken into account. In an embodiment, at least two of the points have to take place. In another embodiment, at least three of the points have to take place. In another embodiment, at least four of the points have to take place.

For certain applications, the way the temperature is applied, has a surprisingly strong influence both on the accuracy attainable in the manufactured component and the lack of defects for some geometries. It has been found by the inventor that one way to make the whole process even more economically advantageous is by reducing the heating time in step ii) (in some instances in steps ii) and iii)). In an embodiment, the heating in steps ii) and/or iii) is made with microwaves. One way to achieve this objective is by means of microwave heating, which is very challenging given that it has to be performed in a highly pressurized chamber. In an embodiment, the highly pressurized chamber comprises a properly designed atmosphere (as previously defined). In an embodiment, heating in step ii) is at least partially made with microwaves. In an embodiment, heating in step iii) is at least partially made with microwaves. In an embodiment, the pressure and/or temperature treatment comprises applying a microwave heating. Unless otherwise stated, the feature “microwave heating” is defined throughout the present document in the form of different alternatives that are explained in detail below. In an embodiment, the microwave heating comprises the use of a properly designed atmosphere (as previously defined). In an embodiment, when heating is made with microwaves the predominant frequency is in the 2.45 GHz +/−250 MHz. In an embodiment, when heating is made with microwaves the predominant frequency is in the 5.8 GHz +/−1050 MHz. In an embodiment, when heating is made with microwaves the predominant frequency is in the 915 MHz +/−250 MHz. In an embodiment, when heating is made with microwaves the predominant frequency is in the 2.45 MHz +/−250 MHz. For some applications, the total power of the microwave generators employed is important. In different embodiments, the total employed power is 55 W or more, 155 W or more, 355 W or more, 555 W or more, 1055 W or more and even 3055 W or more. For some applications, it has been proven more efficient to control the total employed power. In different embodiments, the total employed power is 55000 W or less, 19000 W or less, 9000 W or less, 3900 W or less and even 900 W or less. All the embodiments disclosed above can be combined among them in any combination, provided that they are not mutually exclusive, for example: in an embodiment, the total employed the total power of the microwave generator is between 55 W and 55000 W. To the inventor knowledge there are no instances of high pressure chambers like the ones employed in this invention where microwave heating is possible with the frequencies and powers employed in this invention. In different embodiments, a high pressurized chamber means a chamber pressurized with a fluid to 1200 bars or more, 2100 bars or more, 2600 bars or more, 3010 bars or more, 3800 bars or more and even 4200 bars or more. In an embodiment, a chamber pressurized with a fluid to 1200 bars or more and comprising some pieces with a pertinent dielectric susceptibility is heated with microwaves within the frequencies indicated above. In another embodiment, a chamber pressurized with a fluid to 1200 bars or more and comprising some pieces with a pertinent dielectric susceptibility is heated with microwaves with the power in the chamber within the ranges indicated above for the total power of the microwave generator. In another embodiment, a high pressurized chamber means a chamber pressurized with a fluid to 2100 bars or more and comprising some pieces with a pertinent dielectric susceptibility is heated with microwaves within the frequencies indicated above. In another embodiment, a chamber pressurized with a fluid to 2100 bars or more and comprising some pieces with a pertinent dielectric susceptibility is heated with microwaves with the power in the chamber within the ranges indicated above for the total power of the microwave generator. In another embodiment, a chamber pressurized with a fluid to 2600 bars or more and comprising some pieces with a pertinent dielectric susceptibility is heated with microwaves within the frequencies indicated above. In another embodiment, a chamber pressurized with a fluid to 2600 bars or more and comprising some pieces with a pertinent dielectric susceptibility is heated with microwaves with the power in the chamber within the ranges indicated above for the total power of the microwave generator. In another embodiment, a chamber pressurized with a fluid to 3010 bars or more and comprising some pieces with a pertinent dielectric susceptibility is heated with microwaves within the frequencies indicated above. In another embodiment, a chamber pressurized with a fluid to 3010 bars or more and comprising some pieces with a pertinent dielectric susceptibility is heated with microwaves with the power in the chamber within the ranges indicated above for the total power of the microwave generator. In another embodiment, a chamber pressurized with a fluid to 3800 bars or more and comprising some pieces with a pertinent dielectric susceptibility is heated with microwaves within the frequencies indicated above. In another embodiment, a chamber pressurized with a fluid to 3800 bars or more and comprising some pieces with a pertinent dielectric susceptibility is heated with microwaves with the power in the chamber within the ranges indicated above for the total power of the microwave generator. In another embodiment, a chamber pressurized with a fluid to 4200 bars or more and comprising some pieces with a pertinent dielectric susceptibility is heated with microwaves within the frequencies indicated above. In another embodiment, a chamber pressurized with a fluid to 4200 bars or more and comprising some pieces with a pertinent dielectric susceptibility is heated with microwaves with the power in the chamber within the ranges indicated above for the total power of the microwave generator. In an embodiment, the material with the pertinent dielectric susceptibility comprises at least part of the powder filling the polymeric molds. In an embodiment, the material with the pertinent dielectric susceptibility comprises the polymeric molds. In an embodiment, the material with the pertinent dielectric susceptibility is constrained to at least part of the powder filling the polymeric molds. In another embodiment, the material with the pertinent dielectric susceptibility is constrained to the powder filling the polymeric molds. It has been found with rather surprise that for many applications, it works better when the polymeric mold has the right level of polarity rather than the pertinent dielectric susceptibility. In an embodiment, the polymeric mold containing the powder presents the right level of polarity. In another embodiment, the pressurizing fluid in the chamber comprises at least one fluid with the right level of polarity. In another embodiment, all fluids in the pressurizing chamber present the right level of polarity. In another embodiment, at least one of the pressurizing fluids in the chamber is a fluid with the right level of viscosity. In another embodiment, all the pressurizing fluids in the chamber are a fluid with the right level of viscosity. In an embodiment, at least one of the pressurizing fluids in the chamber is a fluid with the proper temperature resistance (as previously defined). In another embodiment, all the pressurizing fluids in the chamber are a fluid with the proper temperature resistance. In an embodiment, the dielectric constant and dielectric loss are measured at room temperature. In an embodiment, the dielectric constant and dielectric loss are measured at 2.45 GHz. In an alternative embodiment, the dielectric constant and dielectric loss are measured at 915 MHz. In different embodiments, the pertinent dielectric susceptibility means a dielectric loss of 2.09 or more, of 4.09 or more, of 10.49 or more, of 20.97 or more, of 40.9 or more and even of 80.2 or more. For some applications, an excessively high dielectric loss does surprisingly not work as well even when 2.45 GHz microwave heating is employed. In different embodiments, the pertinent dielectric susceptibility means a dielectric loss of 199 or less, of 99 or less, of 49 or less and even of 19 or less. In different embodiments, the pertinent dielectric susceptibility means a dielectric constant of 2.4 or more, of 6 or more, of 11 or more, of 51 or more and even of 11000 or more. For some applications, an excessive dielectric constant surprisingly causes trouble. In different embodiments, the pertinent dielectric susceptibility means a dielectric constant of 24000 or less, of 999 or less, of 499 or less and even of 99 or less. In different embodiments, the right level of polarity means a dielectric loss of 3.99 or less, of 1.99 or less, of 1.49 or less, of 0.97 or less, of 0.09 or less and even of 0.009 or less. For some applications, an excessively low dielectric loss does surprisingly not work as well even when 2.45 GHz microwave heating is employed. In different embodiments, the right level of polarity means a dielectric loss of 0.006 or more, of 0.011 or more, of 0.051 or more and even of 0.12 or more. In different embodiments, the right level of polarity means a dielectric constant of 1000 or less, of 48 or less, of 9 or less and even of 3.9 or less. For some applications, an excessively low dielectric constant surprisingly causes trouble. In different embodiments, the right level of polarity means a dielectric constant of 1.1 or more, of 1.6 or more, of 2.1 or more, of 2.4 or more and even of 2.6 or more. In an embodiment, the pressurized chamber acts as a resonator for the microwave wavelengths employed. In an embodiment, the chamber is cylindrical. In another embodiment, the chamber is cylindrical, with some metal plates in a hexahedral positioning to enhance the resonation. In another embodiment, the chamber is cylindrical, with some metal plates in a heptahedral positioning to enhance the resonation. In another embodiment, the chamber is cylindrical, with some metal plates in an octahedral positioning to enhance the resonation. In another embodiment, the chamber is cylindrical, with some metal plates in a dodecahedral positioning to enhance the resonation. In another embodiment, the chamber is cylindrical, with some metal plates in a polygonal positioning to enhance the resonation. In another embodiment, the chamber is cylindrical, with some metal plates in a triangular positioning to enhance the resonation. It was quite surprising to the inventor that the system works immersed in a highly pressurized liquid. For some applications, the way of introducing the microwaves into the pressurized chamber is quite challenging. In an embodiment, a highly pressure resistant magnetron is introduced into the chamber. In an embodiment, only the antenna on the magnetron is introduced into the chamber, provided with a pressure resisting shielding and it is properly sealed. In an embodiment, the connection between the anode of the magnetron and the antenna is interrupted with a feed through to enter the pressurized chamber having the antenna in the high pressure region and the rest of the magnetron outside. In an embodiment, a microwave generator is used. In an embodiment, a solid state microwave generator is used. In an embodiment, the microwave generator is connected to a coaxial feedthrough in one of the walls of the pressure chamber through a coaxial cable. In an embodiment, an antenna or applicator is connected at the high pressure side of the coaxial feedthrough. In an embodiment, the coaxial cable has the proper dimension. In an embodiment, the coaxial feedthrough has the proper dimension. In an embodiment, the coaxial feedthrough has the proper impedance. In an embodiment, the coaxial cable has the proper impedance. In different embodiments, the proper dimension for the coaxial cable or coaxial feedthrough means a nominal outer diameter (OD) of 7/32″ or more, 7/16″ or more, ⅞″ or more and even 1-⅝″ or more. In different embodiments, the proper dimension means 4- 1/16″ or less, 3-⅛″ or less and even 1-⅝″ or less. In different embodiments, the proper impedance means 199 Ohms or less, 150 Ohms or less, 99 Ohms or loss, 69 Ohms or less and even 49 Ohms or less. For some applications, a minimum proper impedance is preferred. In different embodiments, the proper impedance means 1.1 Ohms or more, 11 Ohms or more, 21 Ohms or more and even 41 Ohms or more. The inventor has observed with astonishing surprise, that when using a bit higher powers for the microwave generator, the pieces come out with a much higher green strength due to incipient sintering. This sintering is also more intense in the subsurface than the surface of the piece, and most surprisingly it does not come along with massive deterioration of the fluid applying the pressure to the component. In an embodiment, enough microwave energy is supplied for the powder to start sintering. For some applications, the use of more than one applicator as a microwave source can be particularly interesting. The inventor has found that for some applications, the use of more than one microwave applicator surprisingly reduces the distortion of the manufactured components. The inventor has found that for some applications, the use of more than one microwave applicator is advantageous. In an embodiment, at least 2 microwave applicators are used. In another embodiment, at least 3 microwave applicators are used. In another embodiment, at least 4 microwave applicators are used. For some applications, the number of microwave applicators should be limited. In an embodiment, less than 990 microwave applicators are used. In another embodiment, less than 90 microwave applicators are used. In another embodiment, less than 59 microwave applicators are used. In another embodiment, less than 19 microwave applicators are used. All the embodiments disclosed above can be combined among them in any combination, provided that they are not mutually exclusive, for example, in an embodiment: the number of microwave applicators is between 2 and 990. In an embodiment, the microwave applicators are located inside the pressurized chamber. In an embodiment, at least 2 microwave applicators are located inside the pressurized chamber. In another embodiment, at least 3 microwave applicators are located inside the pressurized chamber. In another embodiment, at least 4 microwave applicators are located inside the pressurized chamber. For some applications, the number of microwave applicators inside the pressurized chamber should be limited. In an embodiment, less than 990 microwave applicators are located inside the pressurized chamber. In another embodiment, less than 90 microwave applicators are located inside the pressurized chamber. In another embodiment, less than 59 microwave applicators are located inside the pressurized chamber. In another embodiment, less than 19 microwave applicators are located inside the pressurized chamber. In an embodiment, the microwave applicator comprises an antenna. In an embodiment, the microwave applicator is an antenna. For some applications, the use of several microwave applicators per generator is advantageous. In an embodiment, the generator comprises at least 2 microwave applicators. In another embodiment, the generator comprises at least 4 microwave applicators. In another embodiment, the generator comprises at least 6 microwave applicators. In another embodiment, the generator comprises at least 8 microwave applicators. For some applications, the number of microwave applicators comprised in the generator should be limited. In an embodiment, the generator comprises less than 19 microwave applicators. In another embodiment, the generator comprises less than 14 microwave applicators. In another embodiment, the generator comprises less than 9 microwave applicators. In another embodiment, the generator comprises less than 4 microwave applicators. In an embodiment, the generator is located inside the pressurized chamber. In another embodiment, the generator is located outside of the pressurized chamber. In an embodiment, the generator is a magnetron. For some applications, the use of multiple microwave generators can be advantageous. In an embodiment, at least 2 microwave generators are used. In another embodiment, at least 4 microwave generators are used. In another embodiment, at least 6 microwave generators are used. In another embodiment, at least 8 microwave generators are used. For some applications, the number of microwave generators should be limited. In an embodiment, less than 19 microwave generators are used. In another embodiment, less than 14 microwave generators are used. In another embodiment, less than 9 microwave generators. In another embodiment, less than 4 microwave generators are used. For some applications, the use of multiple coaxial feedthrough entry points to the pressurized chamber is advantageous. In an embodiment, the pressurized chamber comprises more than 2 coaxial feedthrough entry points. In another embodiment, the pressurized chamber comprises more than 4 coaxial feedthrough entry points. In another embodiment, the pressurized chamber comprises more than 6 coaxial feedthrough entry points. In another embodiment, the pressurized chamber comprises more than 8 coaxial feedthrough entry points. For some applications, the number of coaxial feedthrough entry points to the pressurized chamber should be limited. In an embodiment, the pressurized chamber comprises less than 19 coaxial feedthrough entry points. In another embodiment, the pressurized chamber comprises less than 14 coaxial feedthrough entry points. In another embodiment, the pressurized chamber comprises less than 9 coaxial feedthrough entry points. In another embodiment, the pressurized chamber comprises less than 4 coaxial feedthrough entry points. The inventor has found that for some applications the use of a high electric potential feedthrough is advantageous. In different embodiments, a high electric potential is more than 600 V, more than 1200 V, more than 2200 V, more than 4200 V, more than 5200 V and even more than 11200 V. For some applications, the high electric potential should be limited. In different embodiments, a high electric potential is less than 190000 V, less than 140000 V, less than 110000 V, less than 90000 V, less than 49000 V, less than 19000 V and even less than 9000 V. The inventor has found that for some applications, the use of a high apparent power feedthrough is advantageous. In different embodiments, a high apparent power is more than 1200 VA, more than 6200 VA, more than 11000 VA, more than 26000 VA, more than 52000 VA and even more than 110000 VA. For some applications, the apparent power should be limited. In different embodiments, a high apparent power is less than 990000 VA, less than 440000 VA, less than 240000 VA, less than 190000 VA, less than 110000 VA less than 89000 VA and even less than 49000 VA. The inventor has found that for some applications, the use of a high power feedthrough can be advantageous. In different embodiments, a high power is more than 1100 W, more than 5600 W, more than 10100 W, more than 23600 W, more than 46800 W and even more than 960000 W. For some applications, the power should be limited. In different embodiments, a high power is less than 890000 W, less than 394000 W, less than 214000 W, less than 169000 W, less than 79000 W and even less than 44000 W. All the embodiments disclosed above can be combined among them in any combination, provided that they are not mutually exclusive. The inventor has found that for some applications, the use of a mechanism to displace the elements to be heated surprisingly reduces the distortion of the manufactured components. In an embodiment, the elements to be heated comprise the component which is being manufactured. In an embodiment, the pressurized chamber comprises a mobile system (in the meaning of this document, the mobile system refers to the mechanism used to produce a movement). In an embodiment, the mobile system comprises an electric engine. In an embodiment, the mobile system produces a movement in the horizontal plane. In an embodiment, the mobile system produces a movement in the vertical plane. In an embodiment, the mobile system produces a rotational movement. For some applications, a complex movement is preferred. In an embodiment, the mobile system produces a movement in more than one plane. In an embodiment, the component is displaced in the pressurized chamber. In an embodiment, the movement of the component is made in the horizontal plane. In an embodiment, the movement of the component is made in the vertical plane. In another embodiment, the movement of the component is rotational. In an embodiment, the movement of the component is made in more than one plane. For some applications, the mobile system is located inside the pressurized chamber. The inventor has found that some applications benefit from the use of an element to reflect the microwaves. In an, embodiment, the mobile system comprises a screen. In an embodiment, the mobile system comprises a screen which reflects the microwaves. In an embodiment, the screen is a sheet. In an embodiment, the mobile system comprises a sheet which reflects the microwaves. In an embodiment, the sheet is a metallic sheet. In an embodiment, the sheet is a polished metal sheet. For some applications, the use of glowing materials can be advantageous. In an embodiment, the pressurized chamber comprises glowing materials. In an embodiment, the glowing materials are applied to an element comprised in the pressurized chamber (hereinafter referred as the element supporting the glowing materials). In an embodiment, the glowing materials are applied to the inner face of the element supporting the glowing materials. The glowing materials can be applied by using any available technology. In an embodiment, the glowing materials are applied in powder form. In an embodiment, the glowing materials are sprayed. In an embodiment, the glowing materials are sprayed in powder form. In an embodiment, at least part of the inner face of the element supporting the glowing materials is sprayed with the glowing materials. The inventor has found that for some applications the use of glowing materials comprising at least a metal is preferred. In an embodiment, the glowing materials comprise an alloy. In an embodiment, the glowing materials comprise a metallic alloy. In an embodiment, the glowing materials comprise a molybdenum alloy. In an embodiment, the glowing materials comprise a tungsten alloy. In an embodiment, the glowing materials comprise a tungsten alloy. In an embodiment, the glowing materials comprise a tantalum alloy. In an embodiment, the glowing materials comprise a zirconium alloy. In an embodiment, the glowing materials comprise a nickel alloy. In an embodiment, the glowing materials comprise an iron based alloy. In an embodiment, the glowing materials comprise a material with a high dielectric loss at the interesting frequency range. For some applications, the use of glowing materials comprising carbides is preferred. In an embodiment, the glowing materials comprise titanium carbides (TiC). For some applications, the use of glowing materials comprising borides is preferred. In an embodiment, the glowing materials comprise a barium titanate (BaTiO₃). In an embodiment, the glowing materials comprise a strontium titanate (SrTiO₃). In an embodiment, the glowing materials comprise a barium-strontium titanate (Ba, Sr (TiO₃)). The element supporting the glowing materials may have different geometric forms. In an embodiment, the pressurized chamber comprises an element supporting the glowing materials. In an embodiment, the element supporting the glowing materials has a cylindrical shape. In another embodiment, the element supporting the glowing materials has a square shape. In another embodiment, the element supporting the glowing materials has a rectangular shape. In another embodiment, the element supporting the glowing materials has a spherical shape. In another embodiment, the element supporting the glowing materials has a conical shape. In another embodiment, the element supporting the glowing materials has an irregular geometric shape. For some applications, the microwave applicator and/or the antenna can be located inside the element supporting the glowing materials. In an embodiment, the microwave applicator is inside the element supporting the glowing materials. In an embodiment, the antenna is inside the element supporting the glowing materials. For some applications, the generator may also be located inside the element supporting the glowing materials, although for some applications, a generator located outside of the pressurized chamber is preferred. For some applications, the use of an element supporting the glowing materials made of high temperature resistant materials is advantageous. For some applications, the element supporting the glowing materials is made of a material comprising an alloy. In an embodiment, the element supporting the glowing materials is made of a material comprising a metallic alloy. In another embodiment, the element supporting the glowing materials is made of a material comprising a molybdenum alloy. In another embodiment, the element supporting the glowing materials is made of a material comprising a tungsten alloy. In another embodiment, the element supporting the glowing materials is made of a material comprising a tantalum alloy. In another embodiment, the element supporting the glowing materials is made of a material comprising a zirconium alloy. In another embodiment, the element supporting the glowing materials is made of a material comprising a ceramic. In another embodiment, the element supporting the glowing materials is made of a material comprising a nickel alloy. In another embodiment, the element supporting the glowing materials is made of a material comprising an iron based alloy. In another embodiment, the element supporting the glowing materials is made of a material with a high dielectric loss at the desired frequency range. For some applications, the use of a material comprising carbides is preferred. In an embodiment, the element supporting the glowing materials is made of a material comprising titanium carbides (TiC). For some applications, the use of a material comprising borides is preferred. In an embodiment, the element supporting the glowing materials is made of a material comprising a barium titanate (BaTiO₃). In another embodiment, the element supporting the glowing materials is made of a material comprising a strontium titanate (SrTiO₃). In another embodiment, the element supporting the glowing materials is made of a material comprising a barium-strontium titanate (Ba, Sr (TiO₃)). For some applications, the use of a mixture comprising at least two of the materials disclosed above can also be advantageous, for example an element supporting the glowing materials made of a material comprising a tungsten alloy and a molybdenum alloy. The inventor has found that for some applications the use of radiation shields may be advantageous. In an embodiment, the pressurized chamber comprises a radiation shield. The radiation shield may have different geometric forms and even for some application the use of more than one radiation shield is advantageous. In an embodiment, the radiation shield and the element supporting the glowing materials have the same geometric shape. In an embodiment, the radiation shield and the element supporting the glowing materials have the same geometric shape but differ in size. In an embodiment, the radiation shield has a cylindrical shape. In another embodiment, the radiation shield has a square shape. In another embodiment, the radiation shield has a rectangular shape. In another embodiment, the radiation shield has a spherical shape. In another embodiment, the radiation shield has a conical shape. In another embodiment, the radiation shield has an irregular geometric shape. In an embodiment, the radiation shield and the element supporting the glowing materials are concentrically disposed with respect to each other. In an embodiment, the radiation shield and the element supporting the glowing materials are concentrically disposed about the vertical axis. In an embodiment, the pressurized chamber comprises more than one radiation shield. In another embodiment, the pressurized chamber comprises at least 2 radiation shields. In another embodiment, the pressurized chamber comprises at least 4 radiation shields. In another embodiment, the pressurized chamber comprises at least 6 radiation shields. For some applications, the number of radiation shields should be limited. In an embodiment, the pressurized chamber comprises less than 99 radiation shields. In another embodiment, the pressurized chamber comprises less than 49 radiation shields. In another embodiment, the pressurized chamber comprises less than 19 radiation shields. In another embodiment, the pressurized chamber comprises less than 9 radiation shields. In an embodiment, the radiation shields are concentrically disposed with respect to each other. In an embodiment, the radiation shields are concentrically disposed about the vertical axis. The inventor has found that for some applications, the use of a radiation shield made of a metallic material may be advantageous. In an embodiment, the radiation shield is made of a material comprising an alloy. In an embodiment, the radiation shield is made of a material comprising a metallic alloy. In an embodiment, the radiation shield is made of a material comprising a tungsten alloy. In an embodiment, the radiation shield is made of a material comprising a molybdenum alloy. In an embodiment, the radiation shield is made of a material comprising a tantalum alloy. All the embodiments disclosed above can be combined among them and with any other embodiment disclosed in this document that relates to a “microwave heating” in any combination, provided that they are not mutually exclusive.

The inventor has found that the consolidation of the powder can be improved when the applied pressure is homogenously distributed, especially in the manufacture of metal comprising components. For some applications, the homogeneous distribution of the applied pressure contributes to obtain components with low levels of porosity and internal defects among others. Also, some applications greatly benefit from homogeneous density distribution. Some of the strategies developed for the application of pressure disclosed in this document are new, inventive and of great interest for other component manufacturing methods and thus can constitute an invention on their own. For some applications, the fluid used to apply pressure is very important, especially in the manufacture of components with complex geometries and/or internal voids. In an embodiment the pressure and/or temperature treatment comprises applying the pressure in a homogeneous way. Unless otherwise stated, “the strategies developed for the application of pressure in a homogeneous way” are defined throughout the present document in the form of different alternatives, that are explained in detail below. The inventor has found that for some applications, the problem of applying pressure in a homogenous way over the entire mold or polymeric film can be solved by using a fluid with the right level of viscosity. For some applications, it has been found to be advantageous that the fluid applying the pressure to the mold does not only have the right level of viscosity but also the proper temperature resistance. For some applications, it has been found to be advantageous when the fluid applying the pressure to the mold is hydrophobic. For some applications, it has been found to be advantageous when the fluid applying the pressure to the mold presents the right level of polarity. In an embodiment, the pressure is applied through a fluid with the right level of viscosity. For some applications, the fluid with the right level of viscosity can be employed to apply pressure directly to the mold. The fluid with the right level of viscosity that can be used is not particularly limited. In an embodiment, the fluid with the right level of viscosity comprises a silicon-based material. In an embodiment, the fluid with the right level of viscosity comprises a silicon fluid. In an embodiment, the fluid with the right level of viscosity comprises a fluid with at least one siloxane functional group. In an embodiment, the fluid with the right level of viscosity comprises a polydimethylsiloxane. In an embodiment, the fluid with the right level of viscosity comprises a linear polydimethylsiloxane fluid. In an embodiment, the fluid with the right level of viscosity comprises a silicon oil. In an embodiment, the fluid with the right level of viscosity comprises a perfluorinated oil. In an embodiment, the fluid with the right level of viscosity comprises a perfluorinated polyether oil (PFPE). In an embodiment, the fluid with the right level of viscosity comprises a perfluorinated polyether solid lubricant. In an embodiment, the fluid with the right level of viscosity comprises a lithium base solid lubricant. In an embodiment, the fluid with the right level of viscosity comprises a fluid with at least one olefin functional group. In an embodiment, the fluid with the right level of viscosity comprises a fluid with at least one alphaolefin functional group. In an embodiment, the fluid with the right level of viscosity comprises a polyalphaolefin. In an embodiment, the fluid with the right level of viscosity comprises a metallocene polyalphaolefin. In an embodiment, the fluid with the right level of viscosity comprises an oil. In an embodiment, the fluid with the right level of viscosity comprises a mineral oil. In an embodiment, the fluid with the right level of viscosity comprises a vegetable oil. In an embodiment, the fluid with the right level of viscosity comprises a natural oil. In an embodiment, the fluid with the right level of viscosity comprises a grease. In an embodiment, the fluid with the right level of viscosity comprises an animal grease or fat. In an embodiment, the fluid with the right level of viscosity comprises a grease which comprises a perfluorinated polyether oil (PFPE). In an embodiment, the fluid with the right level of viscosity comprises a grease which comprises a silicone oil. In an embodiment, the fluid with the right level of viscosity comprises a grease which comprises a perfluorinated polyether solid lubricant. In an embodiment, the fluid with the right level of viscosity comprises a grease which comprises a lithium base solid lubricant. In an embodiment, the fluid with the right level of viscosity comprises a grease with a NLGI index greater than 000. In an embodiment, the fluid with the right level of viscosity comprises a grease with a NLGI index greater than 00. In an embodiment, the fluid with the right level of viscosity comprises a grease with a NLGI index (acc. To DIN 51818) greater than 0. In an embodiment, the fluid with the right level of viscosity comprises a grease with a NLGI index greater than 1. In an embodiment, the fluid with the right level of viscosity comprises a grease with a NLGI index greater than 2. In an embodiment, the fluid with the right level of viscosity comprises a grease with a NLGI index greater than 3. In an embodiment, the fluid with the right level of viscosity comprises a grease with a NLGI index greater or equal to 4. In an embodiment, the fluid with the right level of viscosity comprises a grease with a NLGI index smaller or equal to 00. In an embodiment, the fluid with the right level of viscosity comprises a grease with a NLGI index smaller or equal to 0. In an embodiment, the fluid with the right level of viscosity comprises a grease with a NLGI index smaller or equal to 1. In an embodiment, the fluid with the right level of viscosity comprises a grease with a NLGI index smaller or equal to 2. In an embodiment, the fluid with the right level of viscosity comprises a grease with a NLGI index smaller or equal to 3. In an embodiment, the fluid with the right level of viscosity comprises a grease with a NLGI index smaller than 4. In an embodiment, NLGI index is determined according to DIN 51818. In different embodiments, the fluid with the right level of viscosity has a viscosity of 1.1 cSt or more, 1.6 cSt or more, 6 cSt or more, 26 cSt or more, 106 cSt or more and even 255 cSt or more. For some applications it has been found to be interesting to use much higher levels of viscosity as the right level of viscosity for the fluid applying the pressure to the mold, among others, when the manufacturing method comprises the use of a mold, it allows to work with some imperfections in the sealing of the mold. In different embodiments, the fluid with the right level of viscosity has a viscosity of 1006 cSt or more, 10016 cSt or more, 100026 cSt or more, 1000600 cSt or more and even 1006000 cSt or more. For some applications, fluids with higher viscosities should be employed. In different embodiments, the fluid with the right level of viscosity has a viscosity of 1560000 cSt or more, 11001000 cSt or more, 20001000 cSt or more and even 100001000 cSt or more. For some applications, the inventor has found that when the viscosity of the fluid with the right level of viscosity is too high it leads to cracking of the components before the sintering step. In different embodiments, the fluid with the right level of viscosity has a viscosity below 490000000 cSt, below 94000000 cSt, below 49000000 cSt, below 19000000 cSt, below 9000000 cSt, below 940000 cSt and even below 440000 cSt. In an embodiment, the viscosity is measured at room temperature and 1 atm. In an embodiment, the viscosity is measured according to JISZ8803-2011 at room temperature and 1 atm. All the embodiments disclosed above can be combined among them and with any other embodiment disclosed in this document in any combination, provided that they are not mutually exclusive; for example, a method for manufacturing metal comprising components with complex geometries wherein the pressure is applied through a hydrophobic fluid comprising at least one siloxane functional group with a viscosity of 100026 cSt or more and below 94000000 cSt. In an embodiment, the pressure is applied through a fluid with the right level of polarity. For some applications more than the theoretical polarity of the fluid with the right level of viscosity, it is the dielectric loss and dielectric constant that mater. In an embodiment, the dielectric constant and the dielectric loss are measured at room temperature. In an embodiment, the dielectric constant and the dielectric loss are measured 2.45 GHz. In an alternative embodiment, the dielectric constant and the dielectric loss are measured at 915 MHz. In different embodiments, the right level of polarity means a dielectric loss of 3.99 or less, 1.99 or less, 1.49 or less, 0.97 or less, 0.09 or less and even 0.009 or less. For some applications, an excessively low dielectric loss does surprisingly not work as well even when 2.45 GHz microwave heating is employed. In different embodiments, the right level of polarity means a dielectric loss of 0.006 or more, of 0.011 or more, of 0.051 or more and even of 0.12 or more. In different embodiments, the right level of polarity means a dielectric constant of 48 or less, of 18 or less, of 9 or less and even of 3.9 or less. For some applications, an excessively low dielectric constant surprisingly causes trouble. In different embodiments, the right level of polarity means a dielectric constant of 1.1 or more, of 1.6 or more, of 2.1 or more and even of 2.6 or more. For some applications it is important that the degradation temperature of the fluid with the right level of viscosity is at a right level. In an embodiment, the pressure is applied through a fluid with the proper temperature resistance. In an embodiment, the proper temperature resistance refers to the degradation temperature of the fluid with the right level of viscosity. For some applications it is important that the boiling point of the fluid with the right level of viscosity is at a right level. In an embodiment, the proper temperature resistance refers to the boiling point of the fluid with the right level of viscosity. In an embodiment, the proper temperature resistance is measured at a pressure of 1 atm. In different embodiments, the proper temperature resistance is 56° C. or more, 92° C. or more, 156° C. or more, 206° C. or more and even 356° C. or more. For some applications, an excessive temperature resistance is not desirable often related in turn to the effect of the applied temperature to the change in viscosity of the fluid with the right level of viscosity. In different embodiments, the proper temperature resistance is 588° C. or less, 498° C. or less, 448° C. or less, 387° C. or less, 349° C. or less, 297° C. or less and even 119° C. or less. For some applications, it has been found advantageous to use at least two different fluids to transmit the pressure to the polymeric mold. For some applications, it is interesting to mix the different fluids (even one or more gases with one or more liquids). As has been found for some applications, it is interesting to substitute the fluid by a fluidized bed of solid particles. Also, for some applications mixing solid particles into the fluid transmitting the pressure is interesting. For the sake of simplicity in the remainder of the present paragraph and the rest of the present document, unless otherwise indicated when referring to a fluid used to transmit pressure to the mold directly or indirectly the terminology “fluid” comprises all the exceptions indicated above (mixtures of fluids, fluidized beds of solid particles, solid particles mixed in fluids . . . ). For some applications, it is interesting to have at least two different fluids or mixtures thereof separated from each other. In an embodiment, at least two different fluids separated from each other are employed. In an embodiment, the fluid in direct contact with the mold is separated with a pressure transmitting container from the other fluids. One could name the fluid in direct contact with the polymeric mold the inner fluid and the fluid (or fluids) transmitting pressure to the inner fluid could be named outer fluid. In an embodiment, the inner fluid has a higher kinematic viscosity than at least one of the outer fluids. In different embodiments, the difference is at least 20 cSt, at least 206 cSt, at least 1020 cSt, at least 12000 cSt, at least 102000 cSt, at least 890000 cSt and even at least 2200000 cSt. For some applications, it has been found that an excessive difference in the viscosities of the different pressure transmitting fluids leads to reduced geometrical precision of the method of the present invention. In an embodiment, the maximum difference in kinematic viscosity between the inner fluid and any of the outer fluids is limited. In an embodiment, the maximum difference in kinematic viscosity between the inner fluid and at least one of the outer fluids is limited. In different embodiments, limited means less than 89000000 cSt, less than 19000000 cSt, less than 1900000 cSt and even less than 90000 cSt. In an embodiment, the kinematic viscosity is measured at room temperature and 1 atm. In an embodiment, the kinematic viscosity is measured according to JISZ8803-2011. In an embodiment, the pressure transmitting container is a polymeric film. In another embodiment, the pressure transmitting container is a bag. The material of the pressure transmitting container that can be used is not particularly limited. In an embodiment, the material of the pressure transmitting container comprises an elastomer. In an embodiment, the material of the pressure transmitting container comprises a hydrogenated nitrile (HNBR). In an embodiment, the material of the pressure transmitting container comprises a polyacrylate (ACM). In an embodiment, the material of the pressure transmitting container comprises an ethylene Acrylate (AEM). In an embodiment, the material of the pressure transmitting container comprises a fluorosilicone (FVMQ). In an embodiment, the material of the pressure transmitting container comprises a silicone (VMQ). In an embodiment, the material of the pressure transmitting container comprises a fluorocarbon (FKM). In an embodiment, the material of the pressure transmitting container comprises a TFE/propylene (FEPM). In an embodiment, the material of the pressure transmitting container comprises a perfluorinated elastomer (FFKM). In an embodiment, the material of the pressure transmitting container comprises a polytetrafluorethylene (PTFE). In an embodiment, the material of the pressure transmitting container comprises polyphenylene sulfide (PPS). In an embodiment, the material of the pressure transmitting container comprises polyether ether ketone (PEEK). In an embodiment, the material of the pressure transmitting container comprises polyimide (Pl). In an embodiment, the material of the pressure transmitting container comprises an elastomer. In an embodiment, the material of the pressure transmitting container comprises viton. In an embodiment, the material of the pressure transmitting container comprises ethylene-propylene-diene monomer rubber (EPDM). In an embodiment, the material of the pressure transmitting container comprises a polymer. In an embodiment, the material of the pressure transmitting container comprises a laminated polymer. In an embodiment, the material of the pressure transmitting container comprises at least two laminated polymers. In an embodiment, the material of the pressure transmitting container comprises at least two laminated to each other polymers. In an embodiment, the material of the pressure transmitting container comprises a laminated polymer and a metal comprising foil. In an embodiment, the material of the pressure transmitting container comprises a laminated polymer and a metallic foil. In an embodiment, the material of the pressure transmitting container comprises a laminated polymer and a metallic foil joined trough lamination. In an embodiment, the material of the pressure transmitting container comprises a laminated polymer and a metal comprising adhesive band. In some embodiments, the polymeric materials disclosed in patent application number PCT/EP2019/075743, the contents of which are incorporated herein by reference in their entirety may be advantageously used. The material of the pressure transmitting container is not limited to these materials, however. As previously disclosed, for some applications, the pressure can be applied through a fluidized bed comprising solid particles instead of a fluid with the right level of viscosity. In an embodiment, the pressure is applied through a fluidized bed comprising metal balls. The inventor has found that for some applications, the use of balls made of a metal with the right level of elastic limit is particularly interesting. In an embodiment, the pressure is applied through a fluidized bed comprising metal balls, wherein the metal has the right elastic limit. In different embodiments, a metal with the right elastic limit is a metal with an elastic limit of more than 153 MPa, of more than 210 MPa, of more than 360 MPa, of more than 440 MPa, of more than 620 MPa, of more than 1020 MPa, of more than 1520 MPa and even of more than 2020 MPa. For some applications, the elastic limit should be below a certain value. In different embodiments, a metal with the right elastic limit is a metal with an elastic limit of less than 4940 MPa. of less than 3940 MPa, of less than 2940 MPa, of less than 2480 MPa and even of less than 1980 MPa. For some applications, the use of metal balls made of a metal with a low elastic limit is preferred. In an embodiment, the pressure is applied through a fluidized bed comprising metal balls, wherein the metal has a low elastic limit. In different embodiments, a low elastic limit is 190 MPa or less, 140 MPa or less and even 94 MPa or less. For some applications, an excessively low elastic limit is not helpful. In different embodiments, a low elastic limit is 16 MPa or more, 106 MPa or more and even 160 MPa or more. In an embodiment, the elastic limit is measured according to ASTM E8/E89M-16a at room temperature. Alternatively, for some applications, the use of a fluidized bed comprising balls of other materials such as, but not limited to, plastic balls, polymeric balls ceramic balls, polymeric powder and/or mixtures thereof is advantageous. In an embodiment, the pressure is applied through a fluidized bed comprising ceramic balls. In an embodiment, the pressure is applied through a fluidized bed comprising polymeric balls. For certain applications, the use of a mixture of balls comprising balls of at least two different materials is advantageous. In an embodiment, the pressure is applied through a fluidized bed comprising a mixture of balls of different materials. In some embodiments, the use of spherical balls is preferred. The inventor has found that for certain applications, the size of the balls may be relevant. In different embodiments, the size of the balls is 98 mm or less, 19 mm or less, 9.4 mm or less, 4.4 mm or less, 0.9 mm or less and even 0.42 mm or less. For some applications, the use of balls with an excessively low size is not helpful. In different embodiments, the size of the balls is 0.0016 mm or more, 0.012 mm or more, 0.12 mm or more, 1.1 mm or more and even 11 mm or more. In an embodiment, the size of the balls refers to the mean size of the balls. In some embodiments, the use of balls with the same or a similar size is preferred. On the other hand, in some embodiments, the use of a mixture of balls composed of at least two size fractions is preferred to obtain a better compaction and to ensure a homogeneous transmission of the pressure. For certain applications, the balls size ratio, defined as the ratio between the diameter of large and small balls should be controlled. In different embodiments, the size ratio is 5.1 or more, 7.1 or more, 9.6 or more, 10.2 or more and even 15.6 or more. For certain applications, the size ratio should be maintained below a certain value to ensure a better compaction. In different embodiments, the size ratio is 24.4 or less, 19.4 or less, 9.4 or less, 4.4 or less and even 2.4 or less. In an embodiment, the fluid applying the pressure comprises a fraction of balls. In different embodiments, a fraction of balls is at least 3 vol %, at least 6 vol %, at least 11 vol % at least 16 vol % and even 36 vol %. For certain applications, the pressure can also be advantageously applied through a mixture of polymeric powders. In an embodiment, the pressure is applied through a fluidized bed comprising a powder. In an embodiment, the pressure is applied through a fluidized bed comprising a ceramic powder. In an embodiment, the pressure is applied through a fluidized bed comprising a MgO powder. In an embodiment, the pressure is applied through a fluidized bed comprising a pyrophyllite powder. In an embodiment, the pressure is applied through a fluidized bed comprising a salt powder. In some embodiments, the above disclosed for the mixture of balls can also be extended to a mixture of polymeric powders. For some applications, the use of a fluidized bed comprising particulates of a polymeric material is advantageous. The inventor has surprisingly found that for some applications, the use of a fluidized bed comprising particulates of a polymeric material with a low melting point is particularly interesting. In an embodiment, the low melting temperature polymeric material is allowed to melt at an early stage in the process, before high pressures are applied. In another embodiment, the low melting temperature polymeric material is allowed to melt before the highest pressure is applied. In different embodiments, the pressure is at least partially applied through an at least partially molten polymer with a melting temperature below 249° C., below 194° C., below 123° C., below 93° C. and even below 59° C. For some applications, a polymeric material with an excessively low melting temperature is not helpful. In different embodiments, the pressure is at least partially applied through an at least partially molten polymer with a melting temperature above 26° C., above 57° C. and even above 103° C. For some applications, it is interesting to apply the pressure through a fluidized bed comprising particulates of a polymeric material which do not melt, or at least not completely. In different embodiments, the melting temperature of the polymeric material is above 110° C., above 170° C., above 220° C., above 310° C. and even above 350° C. In an embodiment, the melting temperature is measured according to ISO 11357-1/−3:2016. In an embodiment, the melting temperature is measured applying a heating rate of 206° C./min. For some applications, the size of the polymeric material may be relevant. In different embodiments, the size of the polymeric material is 26 microns or more, 56 microns or more, 76 microns or more and even 96 microns or more. For some applications, the use of polymeric materials having an excessive size may lead to a non-homogeneous distribution of the applied pressure. In different embodiments, the size of the polymeric material is 143 microns or less, 93 microns or less, 68 microns or less and even 44 microns or less. In this context, the size refers to the D50 value. In an embodiment, D50 refers to the particle size at which 50% of the sample's volume is comprised of smaller particles in the cumulative distribution of particle size. In an alternative embodiment, D50 refers to the particle size at which 50% of the sample's mass is comprised of smaller particles in the cumulative distribution of particle size. In an embodiment, D50 is measured by laser diffraction. In an embodiment, D50 is measured by laser diffraction according to ISO 13320-2009. A wide variety of polymeric materials may be employed. In an embodiment, the polymeric material comprises, but is not limited to: polyphenylene sulfide (PPS), polyether other ketone (PEEK), polyimide (Pl), polycaprolactone (PCL), porous polycaprolactone (PCL), polyether other ketone (PEEK). In an embodiment, the polymeric material comprises polyimide (Pl), and/or mixtures thereof. In an embodiment, the polymeric material comprises PPS. In an embodiment, the polymeric material comprises PEEK. In an embodiment, the polymeric material comprises PCL. In an embodiment, the polymeric material comprises Pl. In an embodiment, the polymeric material comprises porous PCL. In some embodiments, the polymeric materials disclosed in patent application number PCT/EP2019/075743, the contents of which are incorporated herein by reference in their entirety may be advantageously used. The polymeric material is not limited to these materials, however. In an embodiment, the above disclosed for the sintering can also be extended to other consolidation treatments. All, all the embodiments disclosed above can be combined among them and with any other embodiment disclosed in this document that relates to the “strategies developed for the application of pressure in a homogeneous way” in any combination, provided that they are not mutually exclusive.

For certain applications, the use of several cycles is advantageous. In an embodiment, at least two cycles of the pressure and/or temperature treatment are applied. In another embodiment, at least three cycles of the pressure and/or temperature treatment are applied.

In some embodiments, the “pressure and/or temperature treatment” as defined above can also be applied to the component obtained after applying the debinding step, in such cases, the pressure and/or temperature is applied to the component or to the pressure transmitting container (polymeric film, bag, a vacuumized bag, conformal coating, mold, etc) placed over the component. In some particular embodiments, the step of forming the component applying pressure and/or temperature can be skipped. Alternatively, in some embodiments, the “pressure and/or temperature treatment” as defined above is applied only to the component obtained after applying the debinding step. In an embodiment, the method for manufacturing at least part of a metal comprising component comprises the following steps:
providing a mold at least partly manufactured by additive manufacturing;
filling the mold with a powder or a powder mixture comprising at least a metal or a metal alloy in powdered form;
forming the component applying a pressure and/or temperature treatment to the mold;
applying a debinding to eliminate at least part of the mold;
optionally, applying a pressure and/or temperature treatment;
setting the oxygen and/or nitrogen level of the metallic part of the component;
applying a consolidation treatment;
applying a high temperature, high pressure treatment; and
optionally, applying a heat treatment and/or machining.

In some embodiments, the powder or powder mixture is formed using a MAM technology. The step of: forming the component from the powder or powder mixture comprising at least a metal or a metal alloy in powdered form using a metal additive manufacturing (MAM) method, wherein the MAM method comprises the use of a polymer and/or binder is also referred throughout the present methods as the forming step. In an embodiment, the MAM technology employed comprise any AM technology comprising the use of metal particles or powders and organic materials (such as, but not limited to polymers, binders and/or mixtures thereof among others). In an embodiment, the MAM technology comprises forming the component layer-by-layer. In an embodiment, the MAM technology comprises the use of radiation to polymerize the polymer and/or binder. Several MAM technologies can be employed to manufacture the component. Non-limiting examples of MAM technologies that can be employed are: fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS), selective heat sintering (SHS), direct energy deposition (DeD), big area additive manufacturing (BAAM) and/or combinations thereof. In an embodiment, the MAM technology comprises the use of a filament or wire comprising a mixture of an organic material and the powder or powder mixture. In an embodiment, the MAM technology comprises fusing at least part of the organic material in the filament or wire. In an embodiment, the MAM technology comprises fusing at least part of the metallic material in the filament or wire. In an embodiment, the MAM method is DLS. In another embodiment, the MAM method is a technology based on CLIP. In another embodiment, the MAM method is a DLS based on CLIP. In another embodiment, the MAM method is SLA. In another embodiment, the MAM method is DLP. In another embodiment, the MAM method is SHS. In another embodiment, the MAM method is SLS. In another embodiment, the MAM method is DOD. In another embodiment, the MAM method is MJF. In another embodiment, the MAM method is CDLP. In another embodiment, the MAM method is MJ. In another embodiment, the MAM method is BJ. In another embodiment, the MAM method is BJ and the binder is applied at each layer. In another embodiment, the MAM method is FDM. In another embodiment, the MAM method is FDM, and the polymer comprising the metal alloy in powdered form or the powder mixture is extruded through a nozzle to deposit the layers onto a platform. In another embodiment, the MAM method is a FDM method where the filament or wire employed comprises a mixture of an organic material and a powder or powder mixture. In another embodiment, the MAM method is a FFF method where the filament or wire employed comprises a mixture of an organic material and a powder or powder mixture. In an embodiment, the powder or powder mixture is a metal comprising powder or powder mixture. In another embodiment, the MAM method is DeD. In another embodiment, the MAM method is DeD where the melting source is a laser. In another embodiment, the MAM method is DeD where the melting source is an electron beam. In another embodiment, the MAM method is DeD where the melting source is an electric arc. In another embodiment, the MAM method is BAAM. In another embodiment, the MAM method is a BAAM method, where deposition is achieved through a system resembling a FDM, and where the filament or wire is a mixture of an organic material and a powder or a powder mixture. In another embodiment, the MAM method is a BAAM method, where deposition is achieved through a system resembling a FDM, and where the filament or wire is a mixture of an organic material and a metallic powder or a metal comprising powder mixture. In another embodiment, the MAM method is a BAAM method, where the component build process is made by means of adhesive bonding of the organic material. In another embodiment, the MAM method is a BAAM method, where the component build process does not involve fusion of metallic particles. In another embodiment, the MAM method is a BAAM method, where deposition is achieved through at least a printer head that projects a powder or powder mixture and an organic material. In another embodiment, the MAM method is a BAAM method, where deposition is achieved through at least one printer head that projects the powder or powder mixture and the organic material separately. In another embodiment, the MAM method is a BAAM method, where deposition is achieved through a system resembling a cold spray system. In another embodiment, the MAM method is a BAAM method, where deposition is achieved by high velocity projection of a powder or powder mixture. In another embodiment, the MAM method is a BAAM method, where deposition is achieved by high velocity projection of a mixture of organic particles and metallic and/or ceramic particles. In another embodiment, the MAM method is a BAAM method, where at least part of the metallic particles are fused during the component build process. In another embodiment, the MAM method is a BAAM method, where all the metallic particles are fused during the component build process. In an embodiment, the metallic particles are added in powder form. In another embodiment, the metallic particles are added in a wire form. In another embodiment, the MAM method is a BAAM method, where the heat source is radiation. In another embodiment, the MAM method is a BAAM method, where the heat source is an infrared heat source. In another embodiment, the MAM method is a BAAM method, where the heat source is an ultrasound source. In another embodiment, the MAM method is a BAAM method, where the heat source is a laser. In another embodiment, the MAM method is a BAAM method, where the heat source is a microwave radiation source/microwave generator. In another embodiment, the MAM method is a BAAM method, where the heat source is an electron beam. In another embodiment, the MAM method is a BAAM method, where the heat source is an electric arc. In another embodiment, the MAM method is a BAAM method, where the heat source is plasma. Alternatively, in some embodiments, a non-additive manufacturing method can be applied to form the component. In some embodiments, the use of at least two different MAM methods is preferred. The inventor has found that for some applications, the organic material (such as, but not limited to, a polymer, binder and/or mixtures thereof) used in the MAM method is not critical as long as the component can maintain the shape through the different steps applied after applying the forming step. In an embodiment, the organic material comprises a thermoplastic polymer. In an embodiment, the organic material comprises a thermosetting polymer. In some embodiments, the organic materials disclosed throughout this document may be advantageously used.

The inventor has found that for some applications the apparent density of the metallic part of the component after applying the forming step is relevant. In different embodiments, the apparent density of the metallic part of the component after applying the forming step is higher than 21%, higher than 31%, higher than 41%, higher than 51%, higher than 71%, higher than 81% and even higher than 86%. For some applications, the apparent density should be kept below certain values. In different embodiments, the apparent density of the metallic part of the component after applying the forming step is less than 99.8%, less than 89.8%, less than 79.8%, less than 69% and even less than 59%. In an embodiment, the apparent density (real density/theoretical density)*100. In an embodiment, the real density of the component is measured by the Archimedes' Principe. In an alternative embodiment, the real density of the component is measured by the Archimedes' Principe according to ASTM B962-08. In an embodiment, the density values are at 20° C. and 1 atm. All the embodiments disclosed above can be combined among them in any combination, provided that they are not mutually exclusive, for example: in an embodiment, the apparent density of the metallic part of the component after applying the forming step is higher than 21% and less than 99.98%; or for example: in an embodiment, the apparent density of the metallic part of the component after applying the forming step is higher than 31% and less than 99.98%.

For some applications, the percentage of non-metallic voids with access to the surface of the component (hereinafter referred as % NMVS) after applying the forming step is relevant. Throughout the present methods, the percentage of non-metallic voids with access to the surface is calculated as follows: % NMVS=(volume of NMVS/volume of NMVT)*100, wherein the volume of NMVT is the total volume of non-metallic voids in the component. In this context, the volumes are in m³. In an embodiment, the non-metallic voids of the component refer to the voids such as, but not limited to, air and/or polymer and/or binder comprised in the metallic part of the component. In an embodiment, the volume of NMVS refers to the volume of voids (such as, but not limited to, air and/or polymer and/or binder) located inside the metallic part of the component with direct access to the surface of the component without crossing a metal part. In an embodiment, the “voids located inside the component with direct access to the surface of the component without crossing a metal part” refers to a geometrical aspect that is located in an interior volume of a component and that is in direct communication with at least one external surface of the component through one exterior opening defined in the external surface of the component. In an embodiment, ceramics are excluded to calculate the volume of voids. In another embodiment, intermetallics are excluded to calculate the volume of voids. In another embodiment, the voids exclude the geometrical aspects that are part of the design of the component, this means that for example, if the component comprises a cooling channel, void or cavity which is part of the design of the component, this geometrical aspect is not considered to calculate the volume of voids. In an embodiment, voids comprise porosity. In another embodiment, voids comprise only porosity. In some embodiments, the volume of the voids is relevant. In an embodiment, the voids having a volume which is above the volume of the component*10⁻² are not considered to calculate the volume of voids. In another embodiment, the voids having a volume which is above the volume of the component*10⁻³ are not considered to calculate the volume of voids. In another embodiment, the voids having a volume which is above the volume of the component*10⁻⁴ are not considered to calculate the volume of voids. In another embodiment, the voids having a volume which is above the volume of the component*10⁻⁵ are not considered to calculate the volume of voids. In another embodiment, the voids having a volume which is above the volume of the component*10⁻⁶ are not considered to calculate the volume of voids. In an embodiment, throughout the present document, the volume of NMVS, and the volume of NMVT is measured according to Pure & Appl. Chern., Vol. 66, No. 8, pp. 1739-1758, 1994.

For some applications, the percentage of non-metallic voids with access to the surface of the component (as previously defined) after applying the forming step is relevant. The inventor has found that for some applications, the presence of some NMVS in the metallic part of the component after applying the forming step is advantageous, particularly when the levels of oxygen and/or nitrogen in the component are controlled. In an embodiment, the % NMVS in the metallic part of the component after applying the forming step is the proper level of % NMVS. Unless otherwise stated, the feature “proper level of % NMVS” is defined throughout the present methods in the form of different alternatives, that are explained in detail below. In different embodiments, the proper level of % NMVS is above 0.02%, above 6%, above 21%, above 31%, above 51%, above 76% and even above 86%. For some applications, the % NMVS should be controlled to avoid an excessively high level. In different embodiments, the proper level of % NMVS is below 99.98%, below 99.8%, below 98%, below 74%, below 49% and even below 24%. All the embodiments disclosed above can be combined among them in any combination, provided that they are not mutually exclusive for example: in an embodiment, the % NMVS in the metallic part of the component after applying the forming step is above 6% and below 99.98%.

The inventor has found that for some applications, what is more relevant is the relation between the volume of NMVS (the volume of voids located inside the metallic part of the component with direct access to the surface of the component without crossing a metal part, as previously defined) and the total volume of the component, being defined the % NMVC=(volume of NMVS/total volume of the component)*100. In an embodiment, the % NMVC in the metallic part of the component after applying the forming step is the proper level of % NMVC. Unless otherwise stated, the feature “proper level of % NMVC” is defined throughout the present methods in the form of different alternatives, that are explained in detail below. In different embodiments, the proper level of % NMVC is above 0.3%, above 1.2%, above 3.2%, above 6.2%, above 12% and even above 22%. For some applications, the % NMVC in the metallic part of the component after applying the forming step should be controlled to avoid an excessively high level. In different embodiments, the proper level of % NMVC is below 64%, below 49%, below 24%, below 18%, below 9% and even below 4%. All the embodiments disclosed above can be combined among them in any combination, provided that they are not mutually exclusive for example: in an embodiment, the % NMVC in the metallic part of the component after applying the forming step is above 0.3% and below 64%.

For some applications, the application of a machining step to the formed component is advantageous. In an embodiment, the method further comprises the step of: applying a machining to the component obtained after the forming step.

In some embodiments, the method comprising forming the component using a MAM method further comprises the step of: applying a “pressure and/or temperature treatment” (as previously defined) before and/or after the debinding step; in such cases, the pressure and/or temperature is applied to the component or to the pressure transmitting container (polymeric film, bag, a vacuumized bag, conformal coating, mold, etc) placed over the component. In an embodiment, the method for manufacturing at least part of a metal comprising component comprises the following steps:
providing a powder or powder mixture comprising at least a metal or a metal alloy in powdered form:
forming the component from the powder or powder mixture comprising at least a metal or a metal alloy in powdered form using a metal additive manufacturing (MAM) method, wherein the MAM method comprises the use of a polymer and/or binder;
optionally, applying a pressure and/or temperature treatment:
applying a debinding to eliminate at least part of the polymer and/or binder;
optionally, applying a pressure and/or temperature treatment;
applying a consolidation treatment to achieve a right apparent density;
applying a high temperature, high pressure treatment; and optionally,
applying a heat treatment and/or machining.

In an embodiment, the method comprises eliminating at least part of the polymer and/or binder or of the mold. The step of: applying a debinding to eliminate at least part of the polymer and/or binder is also referred throughout the present methods as the debinding step. The step of: applying a debinding to eliminate at least part of the mold is also referred throughout the present methods as the debinding step. For some particular applications, the debinding step is optional and therefore can be avoided. In an embodiment, the debinding step is skipped. For some applications, the debinding step is not critical as long as the component does not collapse upon debinding. For some applications, the debinding conditions applied in the methods disclosed throughout in this document can also be applied in any combination with the methods disclosed above, provided they are not mutually exclusive. The debinding method which can be used is not particularly limited as long as the desired amount of organic material is eliminated. Examples of debinding methods that can be employed, include, but are not limited to: thermal debinding, non-thermal debinding (such as, but not limited to, catalytic, wicking, drying, supercritical extraction, organic solvent extraction, water-based solvent extraction or freeze drying . . . ), chemical debinding and/or combinations thereof. In an embodiment, the debinding step comprises a non-thermal debinding. In an embodiment, the debinding step comprises a chemical debinding. In an embodiment, the debinding step comprises a thermal debinding. For some applications, it is important to correctly choose the temperature applied in the debinding step. In different embodiments, the temperature in the debinding step is 51° C. or more, 110° C. or more, 255° C. or more, 355° C. or more, 455° C. or more and even 610° C. or more. For some applications, it is particularly important to avoid excessively high temperatures in the debinding step. In different embodiments, the temperature in the debinding step is 1390° C. or less, 890° C. or less, 690° C. or less, 590° C. or less, 490° C. or less and even 190° C. or less.

For some applications, the atmosphere used in the furnace or pressure vessel where the debinding step is performed is relevant. Accordingly, in some embodiments, it is important to correctly choose the atmosphere in the debinding step to achieve the desirable performance of the manufactured component. In an embodiment, the debinding step comprises the use of a properly designed atmosphere (as previously defined). For certain applications, it is advantageous to change the atmosphere used during the debinding step (such as, but not limited to, the use of a properly designed atmosphere only in a part of the debinding step and/or the use of at least two different properly designed atmospheres in the debinding step). In an embodiment, a properly designed atmosphere is used to perform at least part of the debinding step. Accordingly, any embodiment that relates to a properly designed atmosphere disclosed in this document can be combined with the debinding step in any combination, provided that they are not mutually exclusive. In an embodiment, the debinding step comprises the use of at least 2 different atmospheres. In another embodiment, the debinding step comprises the use of at least 3 different atmospheres. In another embodiment, the debinding step comprises the use of at least 4 different atmospheres. For certain applications, it is advantageous to use a right carbon potential of the furnace or pressure vessel atmosphere in relation to the carbon potential of the surface of the component (as previously defined) in the debinding step. In an embodiment, the debinding step comprises the use of a right carbon potential of the furnace or pressure vessel atmosphere in relation to the carbon potential of the surface of the component (as previously defined). Accordingly, any embodiment that relates to a right carbon potential of the furnace or pressure vessel atmosphere in relation to the carbon potential of the surface of the component disclosed in this document can be combined with the debinding step in any combination, provided that they are not mutually exclusive. For certain applications, it is advantageous to use a right carbon potential of the furnace or pressure vessel atmosphere in relation to the carbon content in the metallic part of the component (as previously defined) after applying the debinding step. In an embodiment, the debinding step comprises the use of a right carbon potential of the furnace or pressure vessel atmosphere in relation to the carbon content in the metallic part of the component (as previously defined) after applying the debinding step. The carbon potential of the furnace or pressure vessel atmosphere in relation to the carbon content in the metallic part of the component after applying the debinding step is defined as the absolute value of [(carbon content in the metallic part of the component after applying the debinding step—carbon potential of the furnace or pressure vessel atmosphere)/carbon potential of the furnace or pressure vessel atmosphere]*100. Accordingly, any embodiment that relates to a right carbon potential of the furnace or pressure vessel atmosphere in relation to the carbon content in the metallic part of the component disclosed in this document can be combined with the debinding step in any combination, provided that they are not mutually exclusive. For certain applications, the use of a right nitriding atmosphere (as previously defined) in the debinding step is advantageous. In an embodiment, the debinding step comprises the use of a right nitriding atmosphere. Accordingly, any embodiment that relates to a right nitriding atmosphere disclosed in this document can be combined with the debinding step in any combination, provided that they are not mutually exclusive. The inventor has found that for some applications, it is particularly advantageous the use of a right nitriding atmosphere comprising the application of a high nitriding temperature in combination with the application of overpressure and/or certain vacuum (as previously defined) in the debinding step. For some applications, what is more relevant is the weight percentage of nitrogen at the surface of the component after applying the debinding step. For a given composition of the powder, the skilled in the art knows how to select the temperature, nitriding potential and other relevant variables, so that according to simulation, the weight percentage of nitrogen (% N) at the surface after applying the debinding step is the right nitrogen content (as previously defined). In an embodiment, simulation is performed with ThermoCal (version 2020b). In an embodiment, the weight percentage of nitrogen at the surface after applying the debinding step is the right nitrogen content (as previously defined). Accordingly, any embodiment that relates to the right nitrogen content disclosed in this document can be combined with the debinding step in any combination, provided that they are not mutually exclusive. For certain applications, the use of an % O₂ comprising atmosphere at the right temperature for the right time (as previously defined) in the debinding step is advantageous. In an embodiment, the debinding step comprises the use of an % O comprising atmosphere at the right temperature for the right time. Accordingly, any embodiment that relates to an % O₂ comprising atmosphere at the right temperature for the right time disclosed in this document can be combined with the debinding step in any combination, provided that they are not mutually exclusive. In an embodiment, the atmosphere used in the debinding step comprises the application of a high vacuum level (as previously defined). Accordingly, any embodiment that relates to a high vacuum level disclosed in this document can be combined with the debinding step in any combination, provided that they are not mutually exclusive. For some applications, the use of a properly designed atmosphere (as previously defined) comprising the application of a high vacuum level (as previously defined) in the debinding step is preferred. In this regard, any embodiment that relates to a high vacuum level disclosed in this document can be combined with the debinding step in any combination, provided that they are not mutually exclusive.

The inventor has found that some applications benefit from the application of a machining step to the component obtained after applying the debinding step. In an embodiment, the method further comprises the step of: applying a machining after the debinding.

As previously disclosed, for some embodiments, the application of a pressure and/or temperature treatment (as previously defined) after the debinding may help to improve the mechanical properties of the manufactured component, in such cases, the pressure and/or temperature is applied to the component or to the pressure transmitting container (polymeric film, bag, a vacuumized bag, conformal coating, mold, etc) placed over the component. In some embodiments, the “pressure and/or temperature treatment” (as previously defined) can also be applied to the component obtained after applying the debinding step. In an embodiment, the method further comprises the step of: applying a pressure and/or temperature treatment (as previously defined) after applying the debinding step.

In some embodiments, the application of a machining step after the pressure and/or temperature treatment is advantageous. In an embodiment, the method further comprises the step of: applying a machining after applying the pressure and/or temperature treatment.

As previously disclosed, for some applications, the nitrogen and/or oxygen content in the metallic part of the component (or in the part of the component manufactured), may have an impact on the mechanical properties which can be reached in the manufactured component. Accordingly, in some embodiments, the method further comprises the step of: setting the oxygen and/or nitrogen level of the metallic part of the component. The step of: setting the oxygen and/or nitrogen level of the metallic part of the component is also referred throughout the present methods as the fixing step. The inventor has found that for some applications, it is advantageous to perform the debinding step and the fixing step simultaneously and/or in the same furnace or pressure vessel. In an embodiment, the debinding step and the fixing step are performed simultaneously. In an embodiment, the debinding step and the fixing step are performed in the same furnace or pressure vessel.

For some applications, the atmosphere used in the furnace or pressure vessel where the fixing step is performed is relevant. Accordingly, in some embodiments, it is important to correctly choose the atmosphere in the fixing step to achieve the desirable performance of the manufactured component. In an embodiment, the fixing step comprises the use of a properly designed atmosphere (such as, but not limited to, the use of a properly designed atmosphere only in a part of the fixing step and/or the use of at least two different properly designed atmospheres in the fixing step). In an embodiment, a properly designed atmosphere is used to perform at least part of the fixing step. Accordingly, any embodiment that relates to a properly designed atmosphere disclosed in this document can be combined with the fixing step in any combination, provided that they are not mutually exclusive. In an embodiment, the fixing step comprises the use of at least 2 different atmospheres. In another embodiment, the fixing step comprises the use of at least 3 different atmospheres. In another embodiment, the fixing step comprises the use of at least 4 different atmospheres. For certain applications, it is advantageous to use a right carbon potential of the furnace or pressure vessel atmosphere in relation to the carbon potential of the surface of the component (as previously defined) in the fixing step. In an embodiment, the fixing step comprises the use of a right carbon potential of the furnace or pressure vessel atmosphere in relation to the carbon potential of the surface of the component (as previously defined). Accordingly, any embodiment that relates to a right carbon potential of the furnace or pressure vessel atmosphere in relation to the carbon potential of the surface of the component disclosed in this document can be combined with the fixing step in any combination, provided that they are not mutually exclusive. For certain applications, it is advantageous to use a right carbon potential of the furnace or pressure vessel atmosphere in relation to the carbon content in the metallic part of the component (as previously defined) after applying the fixing step. In an embodiment, the fixing step comprises the use of a right carbon potential of the furnace or pressure vessel atmosphere in relation to the carbon content in the metallic part of the component (as previously defined) after applying the fixing step. The carbon potential of the furnace or pressure vessel atmosphere in relation to the carbon content in the metallic part of the component after applying the fixing step is defined as the absolute value of [(carbon content in the metallic part of the component after applying the fixing step—carbon potential of the furnace or pressure vessel atmosphere)/carbon potential of the furnace or pressure vessel atmosphere]*100. Accordingly, any embodiment that relates to a right carbon potential of the furnace or pressure vessel atmosphere in relation to the carbon content in the metallic part of the component disclosed in this document can be combined with the fixing step in any combination, provided that they are not mutually exclusive. For certain applications, the use of a right nitriding atmosphere (as previously defined) in the fixing step is advantageous. In an embodiment, the fixing step comprises the use of a right nitriding atmosphere. Accordingly, any embodiment that relates to a right nitriding atmosphere disclosed in this document can be combined with the fixing step in any combination, provided that they are not mutually exclusive. The inventor has found that for some applications, it is particularly advantageous the use of a right nitriding atmosphere comprising the application of a high nitriding temperature in combination with the application of overpressure and/or certain vacuum (as previously defined) in the fixing step. In some embodiments, the use of a right nitriding atmosphere with the right atomic nitrogen content comprising the application of a right nitriding temperature is particularly advantageous when the powder or powder mixture provided comprises a nitrogen austenitic steel powder (as previously defined) or a powder mixture with the mean composition of a nitrogen austenitic steel (as previously defined). In some embodiments, the use of a right nitriding atmosphere with the right atomic nitrogen content comprising the application of a right nitriding temperature is particularly advantageous when the manufactured component has the composition of a nitrogen austenitic steel (as previously defined). In some embodiments, the use of a right nitriding atmosphere with the right atomic nitrogen content comprising the application of a right nitriding temperature is particularly advantageous when the powder or powder mixture provided comprises the right level of % Yeq(1) previously defined in this document. In some embodiments, the use of a right nitriding atmosphere with the right atomic nitrogen content comprising the application of a right nitriding temperature is particularly advantageous when the manufactured component comprises the right level of % Yeq(1) previously defined in this document. In some embodiments, the use of a right nitriding atmosphere with the right atomic nitrogen content comprising the application of a right nitriding temperature is particularly advantageous when at least one of the materials comprised in the manufactured component has the right level of % Yeq(1) previously defined in this document. In some embodiments, the use of a right nitriding atmosphere with the right atomic nitrogen content comprising the application of a right nitriding temperature is particularly advantageous when the powder or powder mixture provided comprises the right content of % Y+% Sc+% REE, % Al+% Y+% Sc+% REE, % Ti+% Y+% Sc+% REE and/or % Al+% Ti+% Y+% Sc+% REE (as previously defined). In some embodiments, the use of a right nitriding atmosphere with the right atomic nitrogen content comprising the application of a right nitriding temperature is particularly advantageous when the manufactured component comprises the right content of % Y+% Sc+% REE, % Al+% Y+% Sc+% REE, % Ti+% Y+% Sc+% REE and/or % Al+% Ti+% Y+% Sc+% REE (as previously defined). In some embodiments, the use of a right nitriding atmosphere comprising the application of a right nitriding temperature is particularly advantageous when the powder or powder mixture provided comprises a steel powder with a right level of % V+% Al+% Cr+% Mo+% Ta+% W+% Nb (as previously defined). In some embodiments, the use of a right nitriding atmosphere comprising the application of a right nitriding temperature is particularly advantageous when the metallic part of the component comprises a right level of % V+% Al+% Cr+% Mo+% Ta+% W+% Nb (as previously defined) at the time the nitriding atmosphere is removed. In some embodiments, the use of a right nitriding atmosphere comprising the application of a low nitriding temperature is particularly advantageous when the manufactured component comprises a right level of % V+% Al+% Cr+% Mo+% Ta+% W+% Nb (as previously defined). In some embodiments, the above disclosed also applies when the debinding step, the consolidation step and/or the densification step comprise the use of a right nitriding atmosphere. For some applications, what is more relevant is the weight percentage of nitrogen at the surface of the component after applying the fixing step. For a given composition of the powder, the skilled in the art knows how to select the temperature, nitriding potential and other relevant variables, so that according to simulation, the weight percentage of nitrogen (% N) at the surface after applying the fixing step is the right nitrogen content (as previously defined). In an embodiment, simulation is performed with ThermoCal (version 2020b). In an embodiment, the weight percentage of nitrogen at the surface after applying the fixing step is the right nitrogen content (as previously defined). Accordingly, any embodiment that relates to the right nitrogen content disclosed in this document can be combined with the fixing step in any combination, provided that they are not mutually exclusive. For certain applications, the use of an % O₂ comprising atmosphere at the right temperature for the right time (as previously defined) in the fixing step is advantageous. In an embodiment, the fixing step comprises the use of an % O₂ comprising atmosphere at the right temperature for the right time. Accordingly, any embodiment that relates to an % O₂ comprising atmosphere at the right temperature for the right time disclosed in this document can be combined with the fixing step in any combination, provided that they are not mutually exclusive. In some embodiments the use of an % O₂ comprising atmosphere, as disclosed above, is particularly advantageous when the fixing step is made taking good care to preserve the % NMVS and/or the % NMVC. In some embodiments, the use of an % O₂ comprising atmosphere at the right temperature is advantageous when at least some powders are selected with a high but not extremely high oxygen content (as previously defined). For some applications, it has been found that the fixing of the oxygen level is capital, but even more important the relation of the oxygen content to the content of other elements. In an embodiment, the % O content is chosen to comply with the following formula % O≤KYS*(% Y+1.98*% Sc+2.47*% Ti+0.67% REE), being % REE as previously defined. In another embodiment, the % O content is chosen to comply with the following formula KYI*(% Y+1.98*% Sc+2.47*% Ti+0.67*% REE)<% O≤KYS*(% Y+1.98*% Sc+2.47*% Ti+0.67*% REE), being % REE as previously defined. In different embodiments, KYI is 3800, 2900, 2700, 2650, 2600, 2400, 2200, 2000 and even 1750. In different embodiments, KYS is 2100, 2350, 2700, 2750, 2800, 3000, 3500, 4000, 4500 and even 8000. In an alternative embodiment, what has been disclosed above in this paragraph is modified to ignore % Ti, so that the % Ti contained in the material is not taken into account for the calculations of acceptable % O. In an embodiment, the % O, % Y, % Sc, % Ti and % REE refers to the content of these elements in the metallic part of the component after applying the fixing step. Alternatively, in some embodiments, the inventor has found that it is particularly advantageous when the % O content in the manufactured component (or at least in one of the materials comprised in the manufactured component) is chosen to comply with the above disclosed formulas. In an alternative embodiment, the % O, % Y, % Sc, % Ti and % REE refers to the content of these elements in the manufactured component. In another alternative embodiment, the % O, % Y, % Sc, % Ti and % REE refers to the content of these elements in at least one of the materials comprised in the manufactured component. In another alternative embodiment, the % O, % Y, % Sc, % Ti and % REE refers to the content of these elements at some point during the application of the method. In some embodiments, the use of an % O₂ comprising atmosphere at the right temperature for the right time is advantageous when the powder or powder mixture provided comprises a nitrogen austenitic steel powder (as previously defined) or a powder mixture with the mean composition of a nitrogen austenitic steel (as previously defined). In some embodiments, the use of an % O₂ comprising atmosphere at the right temperature for the right time is particularly advantageous when the manufactured component has the composition of a nitrogen austenitic steel (as previously defined). In some embodiments, the use of an % O₂ comprising atmosphere at the right temperature for the right time is particularly advantageous when the powder or powder mixture provided comprises the right level of % Yeq(1) (as previously defined). In some embodiments, the use of an % O₂ comprising atmosphere at the right temperature for the right time is particularly advantageous when the manufactured component comprises the right level of % Yeq(1) (as previously defined). In some embodiments, the use of an % O₂ comprising atmosphere at the right temperature for the right time is particularly advantageous when the powder or powder mixture provided comprises the right content of % Y+% Sc+% REE, % Al+% Y+% Sc+% REE, % Ti+% Y+% Sc+% REE and/or % Al+% Ti+% Y+% Sc+% REE (as previously defined). In some embodiments, the use of an % O₂ comprising atmosphere at the right temperature for the right time is particularly advantageous when the manufactured component comprises the right content of % Y+% Sc+% REE, % Al+% Y+% Sc+% REE, % Ti+% Y+% Sc+% REE and/or % Al+% Ti+% Y+% Sc+% REE (as previously defined). In some embodiments, the above disclosed also applies when the debinding step, the consolidation step and/or the densification step comprise the use of an % O₂ comprising atmosphere. In an embodiment, the atmosphere used in the fixing step comprises the application of a high vacuum level (as previously defined). Accordingly, any embodiment that relates to a high vacuum level disclosed in this document can be combined with the fixing step in any combination, provided that they are not mutually exclusive. For some applications, the use of a properly designed atmosphere (as previously defined) comprising the application of a high vacuum level (as previously defined) in the fixing step is preferred. Accordingly, any embodiment that relates to a high vacuum level disclosed in this document can be combined with the fixing step in any combination, provided that they are not mutually exclusive. In an embodiment, the presence of a certain content of % Moeq and a certain content of % C or % Ceq (as previously defined) is particularly advantageous to achieve the right levels of oxygen in the metallic part of the component when the fixing step comprises the use of a properly designed atmosphere (as previously defined). All the embodiments disclosed above can be combined among them and with any other embodiment disclosed in this document, in any combination, provided that they are not mutually exclusive, for example a steel powder where % Moeq is above 0.11 wt % and % C is below 0.98 wt %, wherein the fixing step is performed in an atmosphere comprising mostly Ar; or for example a steel powder where % Moeq is below 14 wt % and % Ceq is above 0.11 wt %, wherein the fixing step is performed in an atmosphere comprising mostly % H₂ (as previously defined).

For some applications, the combination of a certain content of % Moeq and a certain content of % C or % Ceq (as previously defined) may also help to achieve the right levels of nitrogen in the component. For some applications, when the powder is a stainless steel powder or a powder mixture with the overall composition of a stainless steel with the % Cr contents previously disclosed it is particularly advantageous to achieve the right levels of oxygen in the metallic part of the component when the atmosphere used in the fixing step is a properly designed atmosphere as previously defined. Accordingly, any embodiment that relates to a properly designed atmosphere can also applied in the fixing step in any combination, provided that they are not mutually exclusive, for example a stainless steel powder where % Cr is above 10.6 wt %, wherein the fixing step is performed in an atmosphere comprising 55 wt % or more % H₂; or for example a stainless steel powder where % Cr is less than 49 wt %, wherein fixing step is performed in an atmosphere comprising 55 wt % or more % H₂. For some applications, it is particularly advantageous to perform the fixing step in an atmosphere comprising more than 4 wt % of % H₂.

The inventor has found, that for some applications, it is particularly advantageous to use an adequate temperature in the fixing step. In an embodiment, the fixing step comprises the application of an adequate temperature. In different embodiments, an adequate temperature refers to a temperature above 220° C., above 420° C., above 610° C., above 920° C., above 1020° C. and even above 1120° C. For some applications, the adequate temperature should be controlled and maintained below a certain value. In different embodiments, an adequate temperature refers to a temperature below 1490° C., below 1440° C., below 1398° C. below 1348° C. and even below 1295° C. All the embodiments disclosed above can be combined among them in any combination, provided that they are not mutually exclusive, for example: in an embodiment, the fixing step comprises the application of a temperature above 220° C. and below 1490° C.

In some embodiments, the combination of a certain content of % Moeq and a certain content of % C or % Ceq (as previously defined) is particularly advantageous to achieve the right levels of oxygen in the metallic part of the component when an adequate temperature is employed in the fixing step. All the embodiments disclosed above can be combined among them in any combination, provided that they are not mutually exclusive, for example a steel powder with a % Moeq above 0.11 wt % and a % C of less than 0.98 wt % wherein the adequate temperature in the fixing step is below 1490° C.; or for example a steel powder where % Moeq is below 14 wt % and % Ceq is above 0.11 wt %, wherein the adequate temperature in the fixing step is above 220° C.

As previously disclosed, for some applications, it is particularly advantageous to set the oxygen level of the metallic part of the component. In an embodiment, the metallic part of the component has the right level of oxygen after applying the fixing step. Unless otherwise stated, the feature “right level of oxygen” is defined throughout the present document in the form of different alternatives that are explained in detail below. In different embodiments, the right level of oxygen is less than 390 ppm, less than 140 ppm, less than 90 ppm, less than 49 ppm, less than 19 ppm, less than 9 ppm and even less than 4 ppm. All expressed in wt %. On the other hand, for some applications, a certain oxygen content in the metallic part of the component after applying the fixing step is preferred. In different embodiments, the right level of oxygen is more than 0.02 ppm, more than 0.2 ppm, more than 1.2 ppm, more than 6 ppm, more than 12 ppm. All expressed in wt %. As disclosed in other parts of this document, for some applications, the presence of very high oxygen contents in the metallic part of the component after applying the fixing step is preferred. In different embodiments, the right level of oxygen is 260 ppm or more, 520 ppm or more, 1100 ppm or more, 2500 ppm or more, 4100 ppm or more, 5200 ppm or more and even 8400 ppm or more. All expressed in wt %. For certain applications, excessively high levels may be detrimental. In different embodiments, the right level of oxygen is 19000 ppm or less, 14000 ppm or less, 9000 ppm or less, 7900 ppm or less, 4800 ppm or less and even 900 ppm or less. All expressed in wt %. All the embodiments disclosed above can be combined among them in any combination, provided that they are not mutually exclusive, for example: in an embodiment, the oxygen level of the metallic part of the component after applying the fixing step is more than 0.02 ppm and less than 390 ppm or for example: in another embodiment, the oxygen level of the metallic part of the component after applying the fixing step is between 260 ppm and 19000 ppm. For some applications, the nitrogen content after applying the fixing step is relevant and should be decreased below a certain level. In an embodiment, the metallic part of the component has the right level of nitrogen after applying the fixing step. Unless otherwise stated, the feature “right level of nitrogen” is defined throughout the present document in the form of different alternatives, that are explained in detail below. In different embodiments, the right level of nitrogen is less than 99 ppm, less than 49 ppm, less than 19 ppm, less than 9 ppm, less than 4 ppm and even less than 0.9 ppm. All expressed in wt %. On the other hand, for some applications, a certain nitrogen content in the metallic part of the component is preferred. In different embodiments, the right level of nitrogen is more than 0.01 ppm, more than 0.06 ppm, more than 1.2 ppm and even more than 5 ppm. As disclosed in other parts of this document, for some applications, the presence of very high nitrogen contents in the metallic part of the component after applying the fixing step is preferred. In different embodiments, the right level of nitrogen is 0.02 wt % or more, 0.2 wt % or more, 0.3 wt % or more, 0.4 wt % or more, 0.6 wt % or more, 0.91 wt % or more and even 1.2 wt % or more. For certain applications, excessively high levels may be detrimental. In different embodiments, the right level of nitrogen is 3.9 wt % or less, 2.9 wt % or less, 1.9 wt % or less, 1.4 wt % or less and even 0.89 wt % or less. All the embodiments disclosed above can be combined among them in any combination, provided that they are not mutually exclusive, for example: in an embodiment, the nitrogen level of the metallic part of the component after applying the fixing step is more than 0.01 ppm and less than 99 ppm; or for example: in another embodiment, the nitrogen level of the metallic part of the component after applying the fixing step is between 0.02 wt % and 3.9 wt %.

For some applications, the fixing step is made taking good care to preserve the % NMVS and/or the % NMVC levels in the metallic part of the component during the fixing step. In an embodiment, the metallic part of the component has the proper level of % NMVS (the proper level of % NMVS as previously defined) after applying the fixing step. In an embodiment, the metallic part of the component has the proper level of % NMVC (the proper level of % NMVC as previously defined) after applying the fixing step. The inventor has found that for certain applications, particularly when an % O₂ comprising atmosphere at the right temperature for the right time (as previously defined) is applied at least in part of the fixing step the % NMVC level in the metallic part of the component may be very relevant. In different embodiments, the % NMVC in the metallic part of the component after applying the fixing step is above 0.4%, above 2.1%, above 4.2%, above 6%, above 11%, above 16% and even above 22%. For some applications, the % NMVC should be maintained below a certain level. In different embodiments, the % NMVC in the metallic part of the component after applying the fixing step is below 64%, below 49%, below 39%, below 14%, below 9% and even below 4%. In an alternative embodiment, the % NMVC levels disclosed above, refer to the % NMVC levels in the metallic part of the component at the time the % O₂ comprising atmosphere at the right temperature for the right time (as previously defined) is removed. Often, the method can be interrupted to measure the % NMVS and/or % NMVC in the metallic part of the component and make sure the levels are as required.

The inventor has found that some applications benefit from the application of a machining step after the fixing step. In an embodiment, the method further comprises a step of: applying a machining to the component obtained after applying the fixing step.

In some embodiments, the component obtained after the debinding or the pressure and/or temperature treatment or the fixing step (depending of the method steps performed), is then consolidated. The step of: applying a consolidation treatment is also referred throughout the present methods as the consolidation step. In an embodiment, the consolidation treatment comprises applying a sintering. In an embodiment, the consolidation treatment is a sintering. In some embodiments, the sintering technique employed is spark plasma sintering (this may also be applied in other parts of the document when reference is made to a sintering). In some particular embodiments, the consolidation step comprises the application of “a high pressure, high temperature cycle where the pressure is strongly variated during the cycle presenting at least two high pressure periods in two different moments in time” (as defined in this document). In some embodiments, at least part of the elimination of the organic material takes place during the consolidation step. In some embodiments, the consolidation step comprises a debinding and a sintering. Even, in some particular embodiments, the consolidation step can be extremely simplified and reduced to a debinding step. In some embodiments, the debinding and the consolidation step can be performed simultaneously and/or in the same equipment (furnace and/or pressure vessel). In an embodiment, the debinding and the consolidation step are performed simultaneously. In an embodiment, the debinding and the consolidation step are performed in the same equipment. In some embodiments, the fixing step and the consolidation step can be performed simultaneously and/or in the same furnace or pressure vessel. In an embodiment, the fixing step and the consolidation step are performed simultaneously. In another embodiment, the fixing step and the consolidation step are performed in the same furnace or pressure vessel. In some embodiments, the debinding, the fixing step and the consolidation step can be performed simultaneously and/or in the same furnace or pressure vessel. In an embodiment, the debinding, the fixing step and the consolidation step are performed simultaneously. In another embodiment, the debinding, the fixing step and the consolidation step are performed in the same furnace or pressure vessel. In an embodiment, when the fixing step and the consolidation step are performed simultaneously (hereinafter referred as the combined step), the % NMVS in the metallic part of the component after applying the fixing step, the % NMVC in the metallic part of the component after applying the fixing step, the apparent density of the metallic part of the component after applying the fixing step, the right level of oxygen in the metallic part of the component after applying the fixing step and the right level of nitrogen in the metallic part of the component after applying the fixing step (as previously defined) are reached at some point of the combined step. For some applications, the above disclosed for the combined step may also be extended to other embodiments, where other method steps (such as, but not limited to, the debinding step and/or the densification step) are performed simultaneously with the fixing step and/or the consolidation step: in such embodiments, the % NMVS in the metallic part of the component after applying the fixing step, the % NMVC in the metallic part of the component after applying the fixing step, the apparent density of the metallic part of the component after applying the fixing step, the right level of oxygen in the metallic part of the component after applying the fixing step and the right level of nitrogen in the metallic part of the component after applying the fixing step (as previously defined) are reached at some point of the corresponding combined steps.

For some applications, the atmosphere used in the furnace or pressure vessel where the consolidation step is performed is relevant. Accordingly, in some embodiments, it is important to correctly choose the atmosphere in the consolidation step to achieve the desirable performance of the manufactured component. In an embodiment, the consolidation step comprises the use of a properly designed atmosphere (as previously defined). For certain applications, it is advantageous to change the atmosphere used during the consolidation step (such as, but not limited to, the use of a properly designed atmosphere only in a part of the consolidation step and/or the use of at least two different properly designed atmospheres in the consolidation step). In an embodiment, a properly designed atmosphere is used to perform at least part of the consolidation step. Accordingly, any embodiment that relates to a properly designed atmosphere disclosed in this document can be combined with the consolidation step in any combination, provided that they are not mutually exclusive. In an embodiment, the consolidation step comprises the use of at least 2 different atmospheres. In another embodiment, the consolidation step comprises the use of at least 3 different atmospheres. In another embodiment, the consolidation step comprises the use of at least 4 different atmospheres. For certain applications, it is advantageous to use a right carbon potential of the furnace or pressure vessel atmosphere in relation to the carbon potential of the surface of the component (as previously defined) in the consolidation step. In an embodiment, the consolidation step comprises the use of a right carbon potential of the furnace or pressure vessel atmosphere in relation to the carbon potential of the surface of the component (as previously defined). Accordingly, any embodiment that relates to a right carbon potential of the furnace or pressure vessel atmosphere in relation to the carbon potential of the surface of the component disclosed in this document can be combined with the consolidation step in any combination, provided that they are not mutually exclusive. For certain applications, it is advantageous to use a right carbon potential of the furnace or pressure vessel atmosphere in relation to the carbon content in the metallic part of the component (as previously defined) after applying the consolidation step. In an embodiment, the consolidation step comprises the use of a right carbon potential of the furnace or pressure vessel atmosphere in relation to the carbon content in the metallic part of the component (as previously defined) after applying the consolidation step. The carbon potential of the furnace or pressure vessel atmosphere in relation to the carbon content in the metallic part of the component after applying the consolidation step is defined as the absolute value of [(carbon content in the metallic part of the component after applying the consolidation step—carbon potential of the furnace or pressure vessel atmosphere)/carbon potential of the furnace or pressure vessel atmosphere]*100. Accordingly, any embodiment that relates to a right carbon potential of the furnace or pressure vessel atmosphere in relation to the carbon content in the metallic part of the component disclosed in this document can be combined with the consolidation step in any combination, provided that they are not mutually exclusive. For certain applications, the use of a right nitriding atmosphere (as previously defined) in the consolidation step is advantageous. In an embodiment, the consolidation step comprises the use of a right nitriding atmosphere. Accordingly, any embodiment that relates to a right nitriding atmosphere disclosed in this document can be combined with the consolidation step in any combination, provided that they are not mutually exclusive. The inventor has found that for some applications, it is particularly advantageous the use of a right nitriding atmosphere comprising the application of a high nitriding temperature in combination with the application of overpressure and/or certain vacuum (as previously defined) in the consolidation step. For some applications, what is more relevant is the weight percentage of nitrogen at the surface of the component after applying the consolidation step. For a given composition of the powder, the skilled in the art knows how to select the temperature, nitriding potential and other relevant variables, so that according to simulation, the weight percentage of nitrogen (% N) at the surface after applying the consolidation step is the right nitrogen content (as previously defined). In an embodiment, simulation is performed with ThermoCal (version 2020b). In an embodiment, the weight percentage of nitrogen at the surface after applying the consolidation step is the right nitrogen content (as previously defined). Accordingly, any embodiment that relates to the right nitrogen content disclosed in this document can be combined with the consolidation step in any combination, provided that they are not mutually exclusive. For certain applications, the use of an % O₂ comprising atmosphere at the right temperature for the right time (as previously defined) in the consolidation step is advantageous. In an embodiment, the consolidation step comprises the use of an % O₂ comprising atmosphere at the right temperature for the right time. Accordingly, any embodiment that relates to an % O₂ comprising atmosphere at the right temperature for the right time disclosed in this document can be combined with the consolidation step in any combination, provided that they are not mutually exclusive. In an embodiment, the atmosphere used in the consolidation step comprises the application of a high vacuum level (as previously defined). Accordingly, any embodiment that relates to a high vacuum level disclosed in this document can be combined with the consolidation step in any combination, provided that they are not mutually exclusive. For some applications, the use of a properly designed atmosphere (as previously defined) comprising the application of a high vacuum level (as previously defined) in the consolidation step is preferred. In this regard, any embodiment that relates to a high vacuum level disclosed in this document can be combined with the consolidation step in any combination, provided that they are not mutually exclusive. For some applications, when the powder is a stainless steel powder or a powder mixture with the overall composition of a stainless steel having the % Cr contents previously disclosed, it is particularly advantageous to perform the consolidation step in a properly designed atmosphere (as previously defined). Accordingly, any embodiment that relates to a properly designed atmosphere can also applied in the consolidation step in any combination, provided that they are not mutually exclusive, for example a stainless steel powder where % Cr is above 10.6 wt %, wherein at least part of the consolidation step is performed in an atmosphere comprising 95.5 wt % or more of H₂. For some applications, it is particularly advantageous to perform the consolidation step in an atmosphere with a H₂ content of more than 4 wt %.

In some applications the consolidation step is very important because it can have a strong contribution in the final properties of the component manufactured, specially on the mechanical and thermo-electrical properties. Also, the consolidation step can be important in some applications requiring seamless and very high performant large components resulting from the joining of smaller components, at least some of which are manufactured with the methods of the present invention, and joined together (as described in this document). Sometimes, the component up to the step of: joint different parts to make a bigger component (as defined later in this document) have internal porosities and sometimes they are detrimental, in the consolidation step they can be reduced or even eliminated.

It has been found that for some applications, performing the consolidation step under pressure may help to achieve very high densities and even full density (the maximum theoretical density). In different embodiments, the pressure in the consolidation step is at least 1 mbar, at least 10 mbar, at least 0.1 bar, at least 1.6 bar, at least 10.1 bar, at least 21 bar and even at least 61 bar. For some applications, the pressure in the consolidation step should be maintained below a certain value. In different embodiments, the pressure in the consolidation step is less than 4900 bar, less than 790 bar, less than 89 bar, less than 8 bar, less than 1.4 bar and even less than 800 mbar. The inventor has found that for some applications, the consolidation step is advantageously performed at a pressure under atmospheric pressure. In an embodiment, the pressure in the consolidation step refers to the maximum pressure applied in the consolidation step. In an alternative embodiment, the pressure in the consolidation step refers to the mean pressure applied in the consolidation step. In another alternative embodiment, the mean pressure is calculated excluding any pressure which is maintained for less than a “critical time” (as previously defined).

For some applications, it is important to correctly choose the temperature applied in the consolidation step. In different embodiments, the temperature in the consolidation step is 0.36*Tm or more, 0.46*Tm or more, 0.54*Tm or more, 0.66*Tm or more, being Tm the melting temperature of the metallic powder with the lowest melting point in the powder mixture. For some applications, even higher temperatures are preferred. In different embodiments, the temperature in the consolidation step is 0.72*Tm or more, 0.76*Tm or more, 0.85*Tm or more and even 0.89*Tm or more, being Tm the melting temperature of the metallic powder with the lowest melting point in the powder mixture. It has been surprisingly found that for some applications, it is advantageous to keep a temperature rather low in the consolidation step. In different embodiments, the temperature in the consolidation step is 0.96*Tm or less, 0.88*Tm or less, 0.78*Tm or less, 0.68*Tm or less and even 0.63*Tm or less, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In other alternative embodiments, Tm refers to the melting temperature of a powder mixture (as previously defined). For some applications, when only one metallic powder is used, Tm is the melting temperature of the metallic powder. In this context, the temperatures disclosed above are in kelvin. In an embodiment, the temperature in the consolidation step refers to the maximum temperature in the consolidation step. In an alternative embodiment, the temperature in the consolidation step refers to the mean temperature in the consolidation step. In another alternative embodiment, the mean temperature is calculated excluding any temperature which is maintained for less than a “critical time” (as previously defined).

For some applications, it can be acceptable, and even advantageous the presence of certain liquid phase during the consolidation in the consolidation step. In such cases even higher temperatures can be applied in the consolidation step. In different embodiments, the temperature in the consolidation step is 0.96*Tm or more, Tm or more, 1.02*Tm or more, 1.06*Tm or more, 1.12*Tm or more, 1.25*Tm or more and even 1.3*Tm or more, being Tm the melting temperature of the metallic powder with the lowest melting point in the powder mixture. For some applications, it is better to define the temperature in the consolidation step in overheating terms. In different embodiments, the temperature in the consolidation step is Tm+1 or more, Tm+11 or more, Tm+22 or more, Tm+51 or more, Tm+105 or more, Tm+205 or more and even Tm+405 or more, being Tm the melting temperature of the metallic powder with the lowest melting point in the powder mixture. It has been found that for some applications, it is advantageous to keep the temperature in the consolidation step below a certain value. In different embodiments, the temperature in the consolidation step is 1.9*Tm or less, 1.49*Tm or less, 1.29*Tm or less and even 1.19*Tm or less, being Tm the melting temperature of the metallic powder with the lowest melting point in the powder mixture. In different embodiments, the temperature in the consolidation step is Tm+890 or less, Tm+450 or less, Tm+290 or less, Tm+190 or less and even Tm+90 or less, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In another alternative embodiment, Tm refers to the melting temperature of a powder mixture (as previously defined). For some applications, when only one metallic powder is used, Tm is the melting temperature of the metallic powder. In this context, the temperatures disclosed above are in kelvin. In an embodiment, the temperature in the consolidation step refers to the maximum temperature in the consolidation step. In an alternative embodiment, the temperature in the consolidation step refers to the mean temperature in the consolidation step. In another alternative embodiment, the mean temperature is calculated excluding any temperature which is maintained for less than a “critical time” (as previously defined). For some of these applications, what is more relevant is the percentage of liquid phase. In different embodiments, the maximum liquid phase during the consolidation step is above 0.2 vol %, above 1.2 vol %, above 3.6 vol %, above 6 vol %, above 11 vol % and even above 21 vol %. For some applications, particularly when the presence of certain liquid phase is preferred, the liquid phase formed should be maintained below a certain value. In different embodiments, the liquid phase at any moment during the consolidation step is maintained below 39 vol %, below 29 vol %, below 19 vol %, below 9 vol % and even below 4 vol %.

It has been found that in some occasions, the components manufactured decrease their density during the consolidation step. This is very prejudicial for some applications, because it leads to a drop of very important properties to those applications. In some cases, this drop of density can be associated to the formation of cavities within the component during the consolidation step process. Many factors seem to influence this behavior, amongst them the sizes of the original powders at the moment when the consolidation step takes place. For some applications where at least two powder types with different chemical nature have been used, and where the final component is severely loaded, efforts have to be undertaken to avoid the loss of density through the consolidation step. For some applications it has been found that a strategy based on proper powder size selection can be advantageous. In an embodiment, all significantly alloyed relevant powders have a mean particle size which is small enough. In an embodiment, all significantly alloyed relevant powders have a D90 which is small enough. In another embodiment, all significantly alloyed relevant powders have a mean particle size which is noticeably smaller than that of the predominant powder. In another embodiment, all significantly alloyed relevant powders have a D90 which is noticeably smaller than that of the predominant powder. In an embodiment, at least one of the significantly alloyed relevant powders has a mean particle size which is small enough. In another embodiment, at least one of the significantly alloyed relevant powders has a D90 which is small enough. In another embodiment, at least one of the significantly alloyed relevant powders has a mean particle size which is noticeably smaller than that of the predominant powder. In another embodiment, at least one of the significantly alloyed relevant powders has a D90 which is noticeably smaller than that of the predominant powder. In this context, for a powder to be significantly alloyed the amount of alloying elements has to be high enough. In different embodiments, for a powder to be significantly alloyed, the sum of all alloying elements should be 6 wt % or more, 12 wt % or more, 22 wt % or more, 46 wt % or more and even 66 wt % or more. In an embodiment, the alloying elements also include the elements where are present but not intentionally added, thus all present alloying elements. In an embodiment, the alloying elements only include those present and intentionally added, thus excluding unavoidable impurities. In an embodiment, the base which is excluded when counting the alloying is the majoritarian element. For some applications, excessive alloying of the significantly alloyed powders is disadvantageous. In different embodiments, for the significantly alloyed powder, the sum of all alloying elements should be 94 wt % or less, 89 wt % or less, 84 wt % or less and even 64 wt % or loss. In this context a powder is relevant, when present in a high enough amount, thus powders with a very low volume fraction are disregarded as not relevant. In different embodiments, a powder is considered relevant when the volume fraction of this powder is 1.2% or more, 4.2% or more, 6% or more, 12% or more and even 22% or more. In this context small enough refers to the size. In different embodiments, a powder is considered small enough when it is smaller than 89 microns, smaller than 49 microns, smaller than 19 microns, smaller than 14 microns and even smaller than 9 microns. For some applications a powder is considered small enough when the size is above a certain value. In different embodiments, a powder is considered small enough when it is higher than 0.9 microns, higher than 2 microns, higher than 6 microns and even higher than 8 microns. In the context of the present paragraph, noticeably smaller refers to the difference in sizes between the addressed powders. In an embodiment, noticeably smaller means 12% or more smaller in size. In another embodiment, noticeably smaller means 20% or more smaller in size. In another embodiment, noticeably smaller means 40% or more smaller in size. In another embodiment, noticeably smaller means 80% or more smaller in size. For some applications noticeably smaller means below a certain value. In an embodiment, noticeably smaller means 240% or less smaller in size. In another embodiment, noticeably smaller means 180% or less smaller in size. In another embodiment, noticeably smaller means 110% or less smaller in size. In another embodiment, noticeably smaller means 90% or less smaller in size. For some applications, the size difference needs to be greater and it is more practical to refer to it in times. In an embodiment, noticeably smaller means 1 to 2.1 or more relation in sizes. In another embodiment, noticeably smaller means 1 to 3.2 or more relation in sizes. In another embodiment, noticeably smaller means 1 to 5.2 or more relation in sizes. In another embodiment, noticeably smaller means 1 to 7.1 or more relation in sizes. In this context the predominant powder is the one which is present in a larger amount. In an embodiment, the predominant powder is the powder present in a higher volume fraction. In an embodiment, the predominant powder is the powder present in a higher volume fraction, where powders are grouped in types according to their composition. In an embodiment, the predominant powder is the powder present in a higher weight fraction.

For some applications it has been found that a good strategy to avoid density loss during the consolidation step, can be based on the consolidation strategy itself. For some applications, it has been found that the negative effect can be significantly reduced if at least a part of the consolidation step is done under pressure. One would expect that best density would be provided with the highest consolidation temperatures as long as there is no phase transformation. Also, in the case of partial melting, the consolidation can be further aided to achieve even higher densities for some applications. It has been found that consolidation under pressure can help in some applications to achieve very high densities even the maximum theoretical density. But very surprisingly it has been found that for several applications, when pressure is applied, the temperature process window to attain very high densities is rather small and surprisingly involving lower temperatures that would be expected. Unless otherwise stated, the feature *consolidation to high densities' is defined throughout the present document in the form of different alternatives, that are explained in detail below. In an embodiment, the consolidation to high densities can be achieved through a process comprising the following steps:
Step 1i: Raising the temperature while keeping a low pressure.
Step 2i: Keeping the temperature at a high level while keeping the pressure at a low level for along enough time period.
Step 3i: Raising the pressure to a high level.
Step 4i: Keeping a high pressure and high temperature for a long enough time period.

In an embodiment, all steps are done in the same furnace/pressure vessel. In an embodiment, all steps are done in a HIP (Hot Isostatic Pressure) equipment. In an embodiment, at least two pieces of equipment are employed to execute all steps 1i-4i. In an embodiment, at least two furnace/pressure vessels are involved to execute steps 1i-4i. In different embodiments, the pressure in step 1i is 900 bar or less, 90 bar or less, 9 bar or less, 1.9 bar or less, 0.9 bar or less and even 900 mbar or less. For some applications, the pressure in step 1i should be maintained above a certain value. In different embodiments, the pressure in step 1i is 0.9 mbar or more, 9 mbar or more, 90 mbar or more and even 0.09 bar or more. In different embodiments, the temperature in step 1i is raised to 0.36*Tm or more, to 0.46*Tm or more, to 0.54*Tm or more, to 0.66*Tm or more, to 0.72*Tm or more and even to 0.76*Tm or more being Tm the melting temperature of the metallic powder with the lowest melting point in the powder mixture. As said, it has been surprisingly found that for some applications it is advantageous to keep temperature in step 1i rather low. In different embodiments, the temperature in step 1i is raised to 0.89*Tm or less, to 0.79*Tm or less, to 0.74*Tm or less, to 0.69*Tm or less and even to 0.64*Tm or less, being Tm the melting temperature of the metallic powder with the lowest melting point in the powder mixture. In alternative embodiments, Tm is the melting temperature of the metallic powder with the lowest melting point in the powder mixture which is a critical powder (as previously defined). In another alternative embodiments, Tm is the melting temperature of the metallic powder with the lowest melting point in the powder mixture which is a relevant powder (as previously defined). In another alternative embodiments, Tm is the mean melting temperature of the metal comprising powder mixture (volume-weighted arithmetic mean, where the weights are the volume fractions). In another alternative embodiments, Tm refers to the melting temperature of a powder mixture (as previously defined). In an embodiment, the pressure levels in step 2i are the same as those in step 1i. In an embodiment, the same limits for pressure described above for step 1i apply for step 2i although the actual pressure value might be different in steps 1i and 2i. In an embodiment, the temperature levels in step 2i are the same as those in step 1i. In an embodiment, the same limits for temperature described above for step 1i apply for step 2i although the actual temperature value might be different in steps 1i and 2i. In different embodiments, a long enough time period in step 2i is 6 minutes or more, 12 minutes or more, 32 minutes or more, 62 minutes or more, 122 minutes or more and even 240 minutes or more. Another interesting and surprising observation has been that for some applications a too long time in step 2i leads to lower density. In different embodiments, the long enough period of time in step 2i is less than 590 minutes, less than 390 minutes, less than 290 minutes, less than 240 minutes, less than 110 minutes and even less than 40 minutes. In different embodiments, the high level of pressure in step 3i is 210 bar or more, 510 bar or more, 810 bar or more, 1010 bar or more, 1520 bar or more and even 2220 bar or more. For certain applications, excessive pressure may be detrimental. In different embodiments, the high level of pressure in step 3i is 6400 bar or less, 2900 bar or less and even 1900 bar or less. In another embodiment, the pressure levels in step 4i are the same as those in step 3i. In another embodiment, the same limits for pressure described above for step 3i apply for step 4i although the actual pressure value might be different in steps 3i and 4i. In different embodiments, the temperature in step 4i is raised to 0.76*Tm or more, to 0.82*Tm or more, to 0.86*Tm or more, to 0.91*Tm or more, to 0.96*Tm or more and even to 1.05*Tm or more. In different embodiments, a long enough time period in step 4i is 16 minutes or more, 66 minutes or more, 125 minutes or more, 178 minutes or more, 250 minutes or more and even 510 minutes or more. For some applications, excessively long times are disadvantageous. In different embodiments, the long enough period of time in step 4i is less than 590 minutes, less than 390 minutes, less than 290 minutes, less than 240 minutes, less than 110 minutes and even less than 40 minutes. In an embodiment, additionally to steps 1i-4i also a debinding step is incorporated. It has been found that some applications benefit from the present strategy when a carbonyl powder is employed in the right amount. In an embodiment, the metal powder mixture employed comprises a carbonyl powder. In an embodiment, the metal powder mixture employed comprises a carbonyl iron powder. In an embodiment, the metal powder mixture employed comprises a carbonyl nickel powder. In an embodiment, the metal powder mixture employed comprises a carbonyl titanium powder. In an embodiment, the metal powder mixture employed comprises a carbonyl cobalt powder. In an embodiment, the carbonyl powder is a high purity powder of the mentioned metal element resulting from the decomposition of the carbonyl. In an embodiment, the carbonyl powder is a high purity powder of the mentioned metal element resulting from the decomposition of the purified carbonyl (as example: highly pure carbonyl iron resulting from the chemical decomposition of purified iron pentacarbonyl). In different embodiments, the carbonyl powder is present in an amount exceeding 6 wt %, exceeding 16 wt %, exceeding 21 wt %, exceeding 36 wt %, exceeding 52 wt % and even exceeding 66 wt % of all metal or metal alloy powders. For some applications, excessive carbonyl content is not desirable. In different embodiments, the carbonyl powder is present in an amount of 79 wt % or less, of 69 wt % or less, of 49 wt % or less, of 39 wt % or less and even of 29 wt % or less. This aspect of the invention is applicable not only to the novel AM methods described in this document, but also to other AM methods presenting also novelty and inventive step, and thus could stand as a standalone invention. In an embodiment, the treatments described in this paragraph are applied to a component comprising an AM step. In an embodiment, the treatments described in this paragraph are applied to a component whose manufacturing comprises a metal AM step. In an embodiment, the treatments described in this paragraph are applied to a component whose manufacturing comprises a metal AM step where the temperatures involved in the binding of the powder to manufacture the component during the AM step are below 0.49*Tm. In an embodiment, the treatments include also the addition of carbonyl metal powder. In an embodiment, the following method is used to attain very high densities and performance in an economic way for a low temperature metal AM method:
Step 1ii: Providing a powder comprising a carbonyl metal powder.
Step 2ii: Manufacturing an object through the additive manufacturing of metal powder with a method where temperatures below 0.49*Tm of the metal powder are employed.
Step 3ii: proceeding with at least the 4 steps of the method described above in this paragraph.

The step 2ii of the method disclosed above involves the use of additive manufacturing of metal powder using temperatures below 0.49*Tm of the metal powder. For some applications, during the additive manufacturing process the binding can be made through processes which are not related to temperature, such as using a glue, or radiation among others. The inventor has found that the use of powder mixtures wherein at least one of the powders comprises % Y, % Sc, and/or REE (as previously defined) may be interesting to apply with the method disclosed above. In an embodiment, at least one of the powders of the mixture comprises % Y. In an embodiment, at least one of the powders of the mixture comprises % Sc. In an embodiment, at least one of the powders of the mixture comprises % REE. In an embodiment, at least one powder comprises % Y, % Sc and/or REE, being the % Fe content above 90 wt %.

For some applications, the oxygen and/or nitrogen level of the metallic part of the component after applying the consolidation step is relevant to mechanical properties. In an embodiment, the metallic part of the component has the right level of oxygen after applying the consolidation step, being the right level of oxygen as previously defined. In an embodiment, the metallic part of the component has the right level of nitrogen after applying the consolidation step, being the right level of nitrogen as previously defined.

The inventor has surprisingly found that there is an unexpected effect in some relevant properties of the manufactured component when the right apparent density levels are reached after applying the consolidation step, and in some cases also with a specific % NMVS and/or % NMVC. In an embodiment, the consolidation step is applied to achieve the right apparent density of the metallic part of the component. The inventor has found that for some applications, depending on the MAM method employed and the composition of the component to be manufactured, unexpected effects can be reached in the thermal conductivity. For some applications, these unexpected effects can also be found in the yield strength and even in some cases in the fracture toughness. In this regard, for some applications, the apparent density of the metallic part of the component after applying the consolidation step should be controlled properly to achieve the required mechanical properties. In different embodiments, apparent density of the metallic part of the component after applying the consolidation step is higher than 81%, higher than 86%, higher than 91%, higher than 94.2%, higher than 96.4%, higher than 99.4% and even full density. For some applications, the apparent density should be kept below a certain value. In different embodiments, the apparent density of the metallic part of the component after applying the consolidation step is less than 99.8%, less than 99.6%, less than 99.4%, less than 98.9%, less than 97.4%, less than 93.9% and even less than 89%. In an embodiment, the above disclosed values of apparent density refer to the right apparent density values. All the embodiments disclosed above can be combined among them in any combination, provided that they are not mutually exclusive, for example: in an embodiment, the apparent density of the metallic part of the component after applying the consolidation step is higher than 81% and less than 99.8%. In an alternative embodiment, the above disclosed values of apparent density are reached at some point of the consolidation step. In another alternative embodiment, the above disclosed values of apparent density are reached after applying the densification step. For certain applications what is more relevant is the percentage of increase of the apparent density of the metallic part of the component after applying the consolidation step, being the percentage of increase defined as the absolute value of [(apparent density after applying the consolidation step—apparent density after applying the forming step)/apparent density after applying the forming step]*100. Alternatively, in some embodiments, the percentage of increase of the apparent density in the metallic part of the component after applying the consolidation step is defined as the absolute value of [(apparent density after applying the consolidation step—apparent density after applying the debinding step)/apparent density after applying the consolidation step]*100. In an embodiment, apparent density refers to apparent density of the metallic part of the component. In different embodiments, the percentage of increase of the apparent density of the metallic part of the component after applying the consolidation step is below 29%, below 19%, below 14%, below 9%, below 4%, below 2% and even below 0.9%. The inventor has found that for some applications a certain increase is preferred. In different embodiments, the percentage of increase of the apparent density of the metallic part of the component after applying the consolidation step is above 6%, above 11%, above 16%, above 22%, above 32% and even above 42%. For some these applications, the percentage of increase of the apparent density of the metallic part of the component after applying the consolidation step should be kept below a certain value. In different embodiments, the percentage of increase of the apparent density of the metallic part of the component after applying the consolidation step is below 69%, below 59%, below 49% and even below 34%. All the embodiments disclosed above can be combined among them in any combination, provided that they are not mutually exclusive, for example: in an embodiment, the percentage of increase of the apparent density of the metallic part of the component after applying the consolidation step is above 6% and below 69%. In an alternative embodiment, the above disclosed values of percentage of increase of the apparent density are reached at some point of the consolidation step. In another alternative embodiment, the above disclosed values of percentage of increase of the apparent density are reached after applying the densification step.

For some applications, it is particularly advantageous to achieve a certain % NMVS after applying the consolidation step. The inventor has found that for some applications, the % NMVS in the metallic part of the component (as previously defined) after applying the consolidation step should be controlled properly. In different embodiments, the % NMVS in the metallic part of the component after applying the consolidation step is below 39%, below 24%, below 14%, below 9%, below 4% and even below 2%. For some applications, lower values are preferred and even their absence (% NMVS=0). On the other hand, some applications benefit from the presence of certain % NMVS. In different embodiments, the % NMVS in the metallic part of the component after applying the consolidation step is above 0.02%, above 0.06%, above 0.2%, above 0.6%, above 1.1% and even above 3.1%. All the embodiments disclosed above can be combined among them in any combination, provided that they are not mutually exclusive, for example: in an embodiment, the % NMVS in the metallic part of the component after applying the consolidation step is above 0.02% and below 39%. In an alternative embodiment, the above disclosed values of % NMVS are reached at some point of the consolidation step. In another alternative embodiment, the above disclosed values of % NMVS are reached after applying the densification step. For some applications what is more relevant is the percentage of reduction of NMVS in the metallic part of the component after applying the consolidation step. In this regard, the percentage of reduction of NMVS=[(total % NMVT in the component after applying the consolidation step*% NMVS in the component after applying the consolidation step)/(total % NMVT in the component after applying the forming step*% NMVS in the component after applying the forming step)]*100, being the total % NMVT in the component=100%-apparent density (being the apparent density in percentage). Alternatively, in some embodiments, the percentage of reduction of NMVS=[(total % NMVT in the component after applying the consolidation step*% NMVS in the component after applying the consolidation step)/(total % NMVT in the component after applying the debinding step*% NMVS in the component after applying the debinding step)]*100, being the total % NMVT in the component=100%-apparent density (being the apparent density in percentage). In an embodiment, % NMVT in the component refers to % NMVT in the metallic part of the component. In an embodiment, % NMVS in the component refers to % NMVS in the metallic part of the component. In an embodiment, apparent density refers to apparent density of the metallic part of the component. In different embodiments, the percentage of reduction of NMVS in the metallic part of the component after applying the consolidation step is above 2.1%, above 6%, above 11%, above 26%, above 51%, above 81% and even above 96%. In an alternative embodiment, the above disclosed values of percentage of reduction of NMVS are reached at some point of the consolidation step. In another alternative embodiment, the above disclosed values of percentage of reduction of NMVS are reached after applying the densification step.

For some applications, the % NMVC in the metallic part of the component after applying the consolidation step should be controlled properly (the % NMVC as previously defined). In different embodiments, the % NMVC in the metallic part of the component after applying the consolidation step is below 9%, below 4%, below 0.9%, below 0.4% and even below 0.09%. For some applications, lower values are preferred and even their absence (% NMVC=0). On the other hand, some applications benefit from the presence of certain % NMVC. In different embodiments, the % NMVC in the metallic part of the component after applying the consolidation step is above 0.002%, above 0.006%, above 0.02%, above 0.6%, above 1.1% and even above 3.1%. All the embodiments disclosed above can be combined among them in any combination, provided that they are not mutually exclusive, for example: in an embodiment, the % NMVC in the metallic part of the component after applying the consolidation step is above 0.002% and below 9%. In an alternative embodiment, the above disclosed values of % NMVC are reached at some point of the consolidation step. In another alternative embodiment, the above disclosed values of % NMVC are reached after applying the densification step.

The inventor has found that some applications benefit from the application of a machining step after the consolidation step. In an embodiment, the method further comprises a step of applying a machining to the component obtained after applying the consolidation step.

The inventor has found that for some applications it is advantageous to apply an additional step to joint different parts after applying the consolidation step. In an embodiment, the method further comprises the step of: joint different parts to make a bigger component before the densification step.

For several applications, this step is very interesting, in particular for the manufacturing of large and very large components. Unless otherwise stated, the feature “joint different parts to make a bigger component” is defined throughout the present document in the form of different alternatives that are explained in detail below. In an embodiment, at least two parts comprising a metal are joined to manufacture a larger component. In another embodiment, at least three parts comprising a metal are joined to manufacture a larger component. In another embodiment, at least two parts from which at least one has been manufactured according to the present invention are joined to manufacture a larger component. In an embodiment, at least three parts from which at least one has been manufactured according to the present invention are joined to manufacture a larger component. In an embodiment, at least three parts from which at least two has been manufactured according to the present invention are joined to manufacture a larger component. In an embodiment, at least two parts manufactured according to the present invention are joined together to manufacture a larger component. In an embodiment, at least three parts manufactured according to the present invention are joined together to manufacture a larger component. In an embodiment, at least five parts manufactured according to the present invention are joined together to manufacture a larger component. In an embodiment, the joining of the parts is made through welding. In an embodiment, the joining of the parts comprises plasma-arc heating. In an embodiment, the joining of the parts comprises electric-arc heating. In an embodiment, the joining of the parts comprises laser heating. In an embodiment, the joining of the parts comprises electron beam heating. In an embodiment, the joining of the parts comprises oxy-fuel heating. In an embodiment, the joining of the parts comprises resistance heating. In an embodiment, the joining of the parts comprises induction heating. In an embodiment, the joining of the parts comprises ultrasound heating. Some applications cannot afford a welding line with different properties. In such case a possible solution is to make a thin welding whose only purpose is to keep the parts together on the joining surfaces for them to diffusion weld in the densification treatment. In an embodiment, a joining is performed with a high temperature glue. In an embodiment, the parts to be joined together have a guiding mechanism to position with the right reference against each other. In an embodiment, the required diagonal for the final component with all the joined parts is 520 mm or more. In an embodiment, the required diagonal is the diagonal of the rectangular cross-section orthogonal to the length of the smallest rectangular cuboid that contains all the joined parts. In an alternative embodiment, the required diagonal is the diameter of the cylinder with smallest radius that contains all the joined parts. In another alternative embodiment, the required diagonal is the diameter of the cylinder with smallest volume that contains all the joined parts. In different embodiments, the required diagonal for the final component with all the joined parts is 620 mm or more, 720 mm or more, 1020 mm or more, 2120 mm or more and even 4120 mm or more. In an embodiment, at least some of the surfaces of the different parts coming together are removed from oxides prior to joining. In an embodiment, at least some of the surfaces of the different parts coming together are removed from organic products prior to joining. In an embodiment, at least some of the surfaces of the different parts coming together are removed from dust prior to joining. In different embodiments, some of the surfaces is at least one of the surfaces, at least two of the surfaces, at least three of the surfaces, at least four of the surfaces, at least five of the surfaces and even at least eight of the surfaces. In an embodiment, at least part of the surfaces of the different parts coming together are removed from dust prior to joining. In an embodiment, the weld recess is designed to assure the joining pulls the faces of the parts joined against each other. In an embodiment, the weld recess is designed to assure the weld (or joining) pulls the faces of the parts joined against each other strongly enough. In different embodiments, strongly enough means that the nominal compressive stress in the surfaces of the different parts that have come together—assembled together—(surfaces of two different parts of the final component in contact to each other after the welding) is 0.01 MPa or more, 0.12 MPa or more, 1.2 MPa or more, 2.6 MPa or more and even 5.12 MPa or more. In an embodiment, the above values are the compressive strength values measured according to ASTM E9-09-2018. In an embodiment, the above disclosed values are at room temperature. In an embodiment, the joining is made in a vacuum environment. In different embodiments, a vacuum environment means 900 mbar or less, 400 mbar or less, 90 mbar or less, 9 mbar or less, 0.9 mbar or less 0.09 mbar or less, 9*10⁻³ mbar or less, 9*10⁻⁵ mbar or less and even 9*10-7 mbar or less. For certain applications, excessive vacuum should be avoided. In different embodiments, a vacuum environment means 10⁻¹¹ mbar or more, 10⁻⁹ mbar or more, 10⁻⁷ mbar or more, 10⁻⁵ mbar or more, 10⁻⁴ mbar or more 10⁻² mbar or more and even 1.1 mbar or more. In an embodiment, the joining is made in an oxygen free environment. In different embodiments, an oxygen free environment means 9% or less, 4% or less, 0.9% or less, 90 ppm or less and even 9 ppm or less. In an embodiment, the above disclosed oxygen percentages are by volume. In an alternative embodiment, the above disclosed oxygen percentages are by weight. In an embodiment, the joining is done all around the periphery of the faces touching each other of at least two of the components coming together in a gas tight way. In an embodiment, a gas tight way means that when the joined component is introduced in a fluid and a high pressure is applied, this fluid cannot flow in the spaces and/or micro-cavities between the two facing each other and joined through all the periphery surfaces of each of the two components assembled together. In different embodiments, a high pressure is 52 MPa or more, 152 MPa or more, 202 MPa or more, 252 MPa or more and even 555 MPa or more. In an embodiment, at least in some areas, the critical depth of weld is small enough. In different embodiments, the critical depth of weld is small enough in at least 6%, at least 16%, at least 26%, at least 56% and even at least 76% of the welding line in the periphery of two faces coming together. In an embodiment, the critical depth of weld refers to the mean value of depth of weld in the length considered. In another embodiment, the critical depth of weld refers to the weighted-through length—mean value of depth of weld in the length considered. In another embodiment, the critical depth of weld refers to the maximum value of depth of weld in the length considered. In another embodiment, the critical depth of weld refers to the minimum value of depth of weld in the length considered. In another embodiment, the critical depth of the weld refers to the extension in depth of the molten zone of the weld. In another embodiment, the critical depth of the weld refers to the extension in depth of the molten zone of the weld evaluated in the cross-section. In another embodiment, the critical depth of the weld refers to the extension in depth of the heat affected zone (HAZ) of the weld. In another embodiment, the critical depth of the weld refers to the extension in depth of the HAZ of the weld evaluated in the cross-section. In an embodiment, the HAZ only incorporates austenized material. In another embodiment, the HAZ only incorporates partially austenized material. In another embodiment, the HAZ only incorporates fully austenized material. In another embodiment, the HAZ incorporates austenized, annealed and tempered-by means of the welding action—material. In another embodiment, the HAZ only incorporates microstructurally altered material—by means of the welding action-. In different embodiments, small enough critical depth of weld is 19 mm or less, 14 mm or less, 9 mm or less, 3.8 mm or loss, 1.8 mm or less, 0.9 mm or loss and even 0.4 mm or less. For some applications, the power density of the heat source plays a role. In different embodiments, the power density is kept below 900 W/mm, below 390 W/mm³, below 90 W/mm³, below 9 W/mm³ and even below 0.9 W/mm³. In an embodiment, the faces touching each other of at least two of the components assembled together undergo diffusion welding in the densification step. In an embodiment, the faces touching each other of at least two of the components assembled together undergo diffusion welding in the densification step and the joining line is removed at least partially. In an embodiment, the faces touching each other of at least two of the components assembled together undergo diffusion welding in the densification step and the joining line is removed at least partially (in terms of the length of the joining line) but completely (in terms of critical depth of weld) from the functional surface of the final component in the substrative machining. Often, the joining of different parts to make a bigger component as defined above is particularly advantageous after the consolidations step, but in some embodiments can also be advantageously applied before the consolidation step (in such cases, the diffusion welding takes place in the consolidation step and/or in the densification step). In an embodiment, the method further comprises the step of: joint different parts to make a bigger component (as defined above) before applying the consolidation treatment. In an embodiment, when the step of joint different parts to make a bigger component is performed before applying the consolidation treatment, the diffusion welding takes place in the consolidation treatment and/or in the high temperature, high pressure treatment.

In some embodiments, the component can be subjected to a densification step comprising the application of high temperatures and/or high pressures. In an embodiment, the component obtained after applying the consolidation step is further subjected to a high temperature, high pressure treatment. The step of: applying a high temperature, high pressure treatment is also referred throughout the present methods as the densification step. In an embodiment, the consolidation step is performed simultaneously with the densification step. In an embodiment, the consolidation step and the densification step are performed in the same furnace or pressure vessel. In an embodiment, the fixing step is performed simultaneously with the consolidation step and the densification step. In an embodiment, the fixing step, the consolidation step and the densification step are performed in the same furnace or pressure vessel. For some applications, the consolidation step is optional and therefore can be avoided. In an embodiment, the consolidation step is skipped. In an embodiment the densification step is applied instead of the consolidation step. The inventor has found that some applications benefit from the application of the pressure in a homogeneous way as previously defined in this document. In an embodiment the densification step comprises applying the “strategies developed for the application of pressure in a homogeneous way”. The inventor has also found that for some applications, it is particularly advantageous to perform at least part of the heating using microwaves. In an embodiment, the densification step comprises applying a “microwave heating” (as previously defined). In an embodiment, the densification step comprises the application of vacuum at a high vacuum level (as previously defined) prior to apply pressure. In an embodiment, the densification step comprises applying a HIP. In an embodiment, the densification step treatment is a HIP. In an embodiment, the densification step comprises the application of “a high pressure, high temperature cycle where the pressure is strongly variated during the cycle presenting at least two high pressure periods in two different moments in time” (as defined in this document). In an embodiment, this cycle and the densification step are performed simultaneously. In an embodiment, this cycle, the consolidation step and the densification step are performed simultaneously. The inventor has found that for some applications, it is advantageous to apply a fast enough cooling (as defined in this document) in the densification step. In an embodiment, the densification step comprises a fast enough cooling. Accordingly, any embodiment that relates to a fast enough cooling disclosed in this document can be combined with the densification step in any combination, provided that they are not mutually exclusive. In an embodiment, the fast enough cooling and the densification step are performed simultaneously. In an embodiment, the fast enough cooling, the consolidation step and the densification step are performed simultaneously.

In an embodiment the densification step is applied more than once. In an embodiment, at least 2 high temperature, high pressure treatments are applied. In another embodiment, at least 3 high temperature, high pressure treatments are applied.

For some applications, the atmosphere used in the furnace or pressure vessel where the densification step is performed is relevant. Accordingly, in some embodiments, it is important to correctly choose the atmosphere in the densification step to achieve the desirable performance of the manufactured component. In an embodiment, the densification step comprises the use of a properly designed atmosphere (as previously defined). For certain applications, it is advantageous to change the atmosphere used during the densification step (such as, but not limited to, the use of a properly designed atmosphere only in a part of the densification step and/or the use of at least two different properly designed atmospheres in the densification step). In an embodiment, a properly designed atmosphere is used to perform at least part of the densification step. Accordingly, any embodiment that relates to a properly designed atmosphere disclosed in this document can be combined with the densification step in any combination, provided that they are not mutually exclusive. In an embodiment, the densification step comprises the use of at least two different atmospheres. In another embodiment, the densification step comprises the use of at least three different atmospheres. In another embodiment, the densification step comprises the use of at least four different atmospheres. For certain applications, it is advantageous to use a right carbon potential of the furnace or pressure vessel atmosphere in relation to the carbon potential of the surface of the component (as previously defined) in the densification step. In an embodiment, the densification step comprises the use of a right carbon potential of the furnace or pressure vessel atmosphere in relation to the carbon potential of the surface of the component (as previously defined). Accordingly, any embodiment that relates to a right carbon potential of the furnace or pressure vessel atmosphere in relation to the carbon potential of the surface of the component disclosed in this document can be combined with the densification step in any combination, provided that they are not mutually exclusive. For certain applications, it is advantageous to use a right carbon potential of the furnace or pressure vessel atmosphere in relation to the carbon content in the metallic part of the component (as previously defined) after applying the densification step. In an embodiment, the densification step comprises the use of a right carbon potential of the furnace or pressure vessel atmosphere in relation to the carbon content in the metallic part of the component (as previously defined) after applying the densification step. The carbon potential of the furnace or pressure vessel atmosphere in relation to the carbon content in the metallic part of the component after applying the densification step is defined as the absolute value of [(carbon content in the metallic part of the component after applying the densification step—carbon potential of the furnace or pressure vessel atmosphere)/carbon potential of the furnace or pressure vessel atmosphere]*100. Accordingly, any embodiment that relates to a right carbon potential of the furnace or pressure vessel atmosphere in relation to the carbon content in the metallic part of the component disclosed in this document can be combined with the densification step in any combination, provided that they are not mutually exclusive. For certain applications, the use of a right nitriding atmosphere (as previously defined) in the densification step is advantageous. In an embodiment, the densification step comprises the use of a right nitriding atmosphere. Accordingly, any embodiment that relates to a right nitriding atmosphere disclosed in this document can be combined with the densification step in any combination, provided that they are not mutually exclusive. The inventor has found that for some applications, it is particularly advantageous the use of a right nitriding atmosphere comprising the application of a high nitriding temperature in combination with the application of overpressure and/or certain vacuum (as previously defined) in the densification step. For some applications, what is more relevant is the weight percentage of nitrogen at the surface of the component after applying the densification step. For a given composition of the powder, the skilled in the art knows how to select the temperature, nitriding potential and other relevant variables, so that according to simulation, the weight percentage of nitrogen (% N) at the surface after applying the densification step is the right nitrogen content (as previously defined). In an embodiment, simulation is performed with ThermoCal (version 2020b). In an embodiment, the weight percentage of nitrogen at the surface after applying the densification step is the right nitrogen content (as previously defined). Accordingly, any embodiment that relates to the right nitrogen content disclosed in this document can be combined with the densification step in any combination, provided that they are not mutually exclusive. For certain applications, the use of an % O₂ comprising atmosphere at the right temperature for the right time (as previously defined) in the densification step is advantageous. In an embodiment, the densification step comprises the use of an % O₂ comprising atmosphere at the right temperature for the right time. Accordingly, any embodiment that relates to an % O₂ comprising atmosphere at the right temperature for the right time disclosed in this document can be combined with the densification step in any combination, provided that they are not mutually exclusive. In an embodiment, the atmosphere used in the densification step comprises the application of a high vacuum level (as previously defined). Accordingly, any embodiment that relates to a high vacuum level disclosed in this document can be combined with the densification step in any combination, provided that they are not mutually exclusive. For some applications, the use of a properly designed atmosphere (as previously defined) comprising the application of a high vacuum level (as previously defined) in the densification step is preferred. In this regard, any embodiment that relates to a high vacuum level disclosed in this document can be combined with the densification step in any combination, provided that they are not mutually exclusive.

For some applications, it is important to correctly choose the pressure applied in the densification step. In different embodiments, the pressure in the high temperature, high pressure treatment is 160 bar or more, 320 bar or more, 560 bar or more, 1050 bar or more and even 1550 bar or more. For some applications, the pressure in the densification step should be maintained below a certain value. In different embodiments, the pressure in the high temperature, high pressure treatment is less than 4900 bar, less than 2800 bar, less than 2200 bar, less than 1800 bar, less than 1400 bar, less than 900 bar and even less than 490 bar. In an embodiment, the pressure in the high temperature, high pressure treatment refers to the maximum pressure applied in the high temperature, high pressure treatment. In an alternative embodiment, the pressure in the high temperature, high pressure treatment refers to the mean pressure applied in the pressure in the high temperature, high pressure treatment. For some applications, it is important to correctly choose the temperature applied in the densification step. In different embodiments, the temperature in the high temperature, high pressure treatment is 0.45*Tm or more, 0.55*Tm or more, 0.65*Tm or more, 0.70*Tm or more, 0.75*Tm or more, 0.8*Tm or more and even 0.86*Tm or more, being Tm the melting temperature of the metallic powder with the lowest melting point in the powder mixture. As said, it has been surprisingly found that for some applications, it is advantageous to keep the temperature rather low. In different embodiments, the temperature in the high temperature, high pressure treatment is 0.92*Tm or less, 0.88*Tm or less, 0.78*Tm or less, 0.75*Tm or less and even 0.68*Tm or less, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In another alternative embodiment, Tm refers to the melting temperature of a powder mixture (as previously defined). For some applications, when only one metallic powder is used, Tm is the melting temperature of the metallic powder. In this context, the temperatures disclosed above are in kelvin. In an embodiment, the temperature in the high temperature, high pressure treatment refers to the maximum temperature applied in the high temperature, high pressure treatment. In an alternative embodiment, the temperature in the high temperature, high pressure treatment refers to the mean temperature applied in the high temperature, high pressure treatment.

For some applications, the oxygen and/or nitrogen level of the metallic part of the component after applying the densification step is relevant to mechanical properties. In an embodiment, the metallic part of the component has the right level of oxygen after applying the densification step, being the right level of oxygen as previously defined. In an embodiment, the metallic part of the component has the right level of nitrogen after applying the densification step, being the right level of nitrogen as previously defined.

For some applications, the apparent density reached in the component after applying the densification step has a great relevance in the mechanical properties. The inventor has found that for some applications, the apparent density of the metallic part of the component after applying the densification step should be controlled properly. In different embodiments, the apparent density of the metallic part of the component after applying the densification step is higher than 96%, higher than 98.2%, higher than 99.2%, higher than 99.6%, higher than 99.82%, higher than 99.96% and even full density. On the other hand, for certain applications it is advantageous to maintain the apparent density below a certain value. In different embodiments, the apparent density of the metallic part of the component after applying the densification step is less than 99.98%, less than 99.94%, less than 99.89%, less than 99.4% and even less than 98.9%. All the embodiments disclosed above can be combined among them in any combination, provided that they are not mutually exclusive, for example: in an embodiment the apparent density of the component after applying the densification step is full density: or for example: in an embodiment, the apparent density of the metallic part of the component after applying the densification step is higher than 96% and less than 99.98%. For certain applications what is more relevant is the percentage of increase of the apparent density of the metallic part of the component after applying the densification step, being the percentage of increase of the apparent density of the metallic part of the component after applying the densification step=the absolute value of [(apparent density of the component after applying the densification step—apparent density of the component after applying the forming step)/apparent density of the component after applying the densification step]*100. Alternatively, the percentage of increase of the apparent density in the metallic part of the component after applying the densification step is defined as the absolute value of [(apparent density after applying the densification step—apparent density after applying the debinding step/apparent density after applying the densification step]*100. In an embodiment, apparent density of the component refers to apparent density of the metallic part of the component. In different embodiments, the percentage of increase of the apparent density of the metallic part of the component after applying the densification step is above 6%, above 11%, above 16%, above 22%, above 32% and even above 42%. For some these applications, the percentage of increase of the apparent density of the metallic part of the component after applying the densification step should be kept below a certain value. In different embodiments, the percentage of increase of the apparent density of the metallic part of the component after applying the densification step is below 69%, below 59%, below 49% and even below 34%. All the embodiments disclosed above can be combined among them in any combination, provided that they are not mutually exclusive, for example: in an embodiment, the percentage of increase of the apparent density of the metallic part of the component after applying the densification step is above 6% and below 69%.

The inventor has found that some applications benefit from the presence of certain % NMVS in the metallic part of the component (as previously defined) after applying the densification step. In different embodiments, the % NMVS in the metallic part of the component after applying the densification step is above 0.002%, above 0.01%, above 0.06%, above 0.1% and even above 2.1%. For some applications, the % NMVS should be controlled. In different embodiments, the % NMVS in the metallic part of the component after applying the densification step is below 29%, below 19%, below 9%, below 4% and even below 2%. For some applications, lower values are preferred and even their absence (% NMVS=0). All the embodiments disclosed above can be combined among them in any combination, provided that they are not mutually exclusive, for example: in an embodiment, the % NMVS in the metallic part of the component after applying the densification step is above 0.002% and below 29%. Alternatively, in some embodiments, the % NMVS levels in the metallic part of the component after applying the consolidation step (as previously defined) are reached after applying the densification step.

For certain applications what is relevant is the percentage of reduction of NMVS in the metallic part of the component after applying the densification step, being the percentage of reduction of NMVS in the metallic part of the component after applying the densification step=[(total % NMVT in the component after applying the densification step *% NMVS in the component after applying the densification step)/(total % NMVT in the component after applying the forming step *% NMVS in the component after applying the forming step)]*100, wherein the total % NMVT of the component=100%-apparent density (being the apparent density in percentage). Alternatively, in some embodiments, the percentage of reduction of NMVS in the metallic part of the component after applying the densification step=[(total % NMVT in the component after applying the densification step *% NMVS in the component after applying the densification step)/(total % NMVT in the component applying the debinding step*% NMVS in the component after applying the debinding step)]*100, wherein the total % NMVT of the component=100%-apparent density (being the apparent density in percentage). In an embodiment, % NMVT in the component refers to % NMVT in the metallic part of the component. In an embodiment, % NMVS in the component refers to % NMVS in the metallic part of the component. In an embodiment, apparent density refers to apparent density of the metallic part of the component. In different embodiments, the percentage of reduction of NMVS in the metallic part of the component after applying the densification step is above 3.6%, above 8%, above 16%, above 32%, above 51%, above 86% and even above 96%. Alternatively, in some embodiments, the percentage of reduction of NMVS levels in the metallic part of the component after applying the consolidation step (as previously defined) are reached after applying the densification step.

The inventor has found that some applications benefit from the presence of certain % NMVC in the metallic part of the component after applying the densification step (the % NMVC as previously defined). In different embodiments, the % NMVC in the metallic part of the component after applying the densification step is above 0.002%, above 0.006%, above 0.01%, above 0.02% and even above 2.2%. For some applications, the % NMVC should be controlled. In different embodiments, the % NMVC in the metallic part of the component after applying the densification step is below 9%, below 1.9%, below 0.8% and even below 0.09%. For some applications, lower values are preferred and even their absence (% NMVC=0). All the embodiments disclosed above can be combined among them in any combination, provided that they are not mutually exclusive, for example: in an embodiment, the % NMVC in the metallic part of the component after applying the densification step is above 0.002% and below 9%. Alternatively, in some embodiments, the % NMVC levels in the metallic part of the component after applying the consolidation step (as previously defined) are reached after applying the densification step. For certain applications what is more relevant is the percentage of reduction of NMVC in the metallic part of the component after applying the densification step, being the percentage of reduction of NMVC in the metallic part of the component after applying the densification step=[(total % NMVT in the component after applying the densification step *% NMVC in the component after applying the densification step)/(total % NMVT in the component after applying the forming step *% NMVC in the component after applying the forming step)]*100, wherein the total % NMVT in the component=100%-apparent density (being the apparent density in percentage). Alternatively, in some embodiments, the percentage of reduction of NMVC in the metallic part of the component after applying the densification step=[(total % NMVT in the component after applying the densification step/% NMVC in the component after applying the densification step)/(total % NMVT in the component after applying the debinding step*% NMVC in the component after applying the debinding step)]*100, wherein the total % NMVT in the component=100%-apparent density (being the apparent density in percentage). In an embodiment, % NMVT in the component refers to % NMVT in the metallic part of the component. In an embodiment, % NMVS in the component refers to % NMVS in the metallic part of the component. In an embodiment, apparent density refers to apparent density in the metallic part of the component. In different embodiments, the percentage of reduction of NMVC in the metallic part of the component after applying the densification step is above 3.6%, above 8%, above 16%, above 36%, above 56%, above 86% and even above 96%.

For some applications, it is advantageous to apply “a high pressure, high temperature cycle where the pressure is strongly variated during the cycle presenting at least two high pressure periods in two different moments in time” (as defined in this document) after applying the densification step. In an embodiment, this cycle and the densification step are performed in the same furnace or pressure vessel.

The inventor has found that in some embodiments, the consolidation step and even the densification step are optionally applied, and thus can be avoided. In an embodiment, the consolidation step and/or the densification step are skipped.

The component obtained using the method steps disclosed in preceding paragraphs can be optionally subjected to “a high pressure, high temperature cycle where the pressure is strongly variated during the cycle presenting at least two high pressure periods in two different moments in time” (as defined in this document) after applying the densification step. In an embodiment, this cycle is applied instead the densification step.

The component obtained using the method steps disclosed in preceding paragraphs can be optionally subjected to a heat treatment to improve the mechanical properties of the manufactured component. In an embodiment, the method further comprises the step of: applying a heat treatment. In an embodiment, the densification step and the heat treatment are performed simultaneously. In an embodiment, in the densification step and the heat treatment are performed in the same furnace or pressure vessel. In an embodiment, the heat treatment comprises a thermo-mechanical treatment. In an embodiment, a heat treatment is applied to the manufactured components. In an embodiment, a heat treatment comprising at least one phase change is applied to the manufactured components. In an embodiment, a heat treatment comprising at least two phase changes is applied to the manufactured components. In an embodiment, a heat treatment comprising at least three phase changes is applied to the manufactured components. In an embodiment, a heat treatment comprising austenitization is applied to the manufactured components. In an embodiment, a heat treatment comprising a solubilization is applied to the manufactured components. In an embodiment, a heat treatment comprising a solubilization is applied to the manufactured components. In an embodiment, a heat treatment comprising a solubilization of a phase is applied to the manufactured components. In an embodiment, a heat treatment comprising a solubilization of an intermetallic phase is applied to the manufactured components. In an embodiment, a heat treatment comprising a solubilization of carbides is applied to the manufactured components. In an embodiment, a heat treatment comprising a high temperature exposition is applied to the manufactured components. In an embodiment high temperature means 0.52*Tm or more. In an embodiment, a heat treatment comprising a controlled cooling is applied to the manufactured components. In an embodiment, a heat treatment comprising a quench is applied to the manufactured components. In an embodiment, a heat treatment comprising a partial phase transformation is applied to the manufactured components. In an embodiment, a heat treatment comprising a martensite transformation is applied to the manufactured components. In an embodiment, a heat treatment comprising a bainitic transformation is applied to the manufactured components. In an embodiment, a heat treatment comprising a precipitation transformation is applied to the manufactured components. In an embodiment, a heat treatment comprising a precipitation of intermetallic phases transformation is applied to the manufactured components. In an embodiment, a heat treatment comprising a carbide precipitation transformation is applied to the manufactured components. In an embodiment, a heat treatment comprising an aging transformation is applied to the manufactured components. In an embodiment, a heat treatment comprising a recrystallization transformation is applied to the manufactured components. In an embodiment, a heat treatment comprising a spheroidization transformation is applied to the manufactured components. In an embodiment, a heat treatment comprising an anneal transformation is applied to the manufactured components. In an embodiment, a heat treatment comprising a tempering transformation is applied to the manufactured components. In an embodiment, the heat treatment comprises a fast enough cooling (as defined in this document). Accordingly, any embodiment that relates to a fast enough cooling disclosed in this document can be combined with the heat treatment in any combination, provided that they are not mutually exclusive.

For some applications, the application of a machining step and/or surface conditioning it is also advantageous. In an embodiment, the method further comprises the step of: applying a machining. In an embodiment, the method further comprises the step of: performing a surface conditioning.

For several applications the addition of a surface conditioning is very interesting, in fact the inventor was inclined to make a thorough research in this area due to the influence on the beneficial impact for some applications. This has led to novel contributions that extend even beyond the scope of the main invention and thus can constitute an invention on their own. Some other applications do better without the surface conditioning and like all the preceding cases that is the reason why it has been incorporated as an additional, non-mandatory for all applications, method step. Unless otherwise stated, the feature “surface conditioning” is defined throughout the present document in the form of different alternatives, that are explained in detail below. In an embodiment, the surface conditioning comprises a chemical modification of at least some of the surface of the manufactured component. In an embodiment, at least part of the surface of the component manufactured in the preceding method steps is altered in a way that the chemical composition changes. In an embodiment, the change in composition is achieved by reaction to an atmosphere. In another embodiment, the change in composition is achieved by carburation. In another embodiment, the change in composition is achieved by nitriding. In another embodiment, the change in composition is achieved by oxidation. In another embodiment, the change in composition is achieved by borurizing. In another embodiment, the change in composition is achieved by sulfonizing. In another embodiment, the change in composition affects % C. In another embodiment, the change in composition affects % N. In another embodiment, the change in composition affects % B. In another embodiment, the change in composition affects % O. In another embodiment, the change in composition affects % S. In another embodiment, the change in composition affects at least two of % B, % C, % N, %/S and % O. In another embodiment, the change in composition affects at least three of % B. % C, % N, % S and % O. In another embodiment, the change in composition affects at least one of % C, % N. % B, % O and/or % S. In another embodiment, the change in composition is achieved by implanting of atoms. In another embodiment, the change in composition is achieved through ion bombardment. In another embodiment, the change in composition is achieved by deposition of a layer. In another embodiment, the change in composition is achieved by growth of a layer. In another embodiment, the change in composition is achieved by chemical vapour deposition (CVD). In another embodiment, the change in composition is achieved by growth of a layer through hard plating. In another embodiment, the change in composition is achieved by hard-chroming. In another embodiment, the change in composition is achieved by electro-plating. In another embodiment, the change in composition is achieved by hard-chroming. In another embodiment, the change in composition is achieved by electrolytic deposition. In another embodiment, the change in composition is achieved by physical vapour deposition (PVD). In another embodiment, the change in composition is achieved by a dense coating. In another embodiment, the change in composition is achieved by high power Impulse magnetron sputtering (HIPIMS). In another embodiment, the change in composition is achieved by high energy arc plasma acceleration deposition. In another embodiment, the change in composition is achieved by a thick coating. In another embodiment, the change in composition is achieved by deposition of a layer through acceleration of particles against the surface. In another embodiment, the change in composition is achieved by thermal spraying. In another embodiment, the change in composition is achieved by cold spray. In another embodiment, the change in composition is achieved by deposition of a layer through a chemical reaction of a paint. In another embodiment, the change in composition is achieved by deposition of a layer through a chemical reaction of a spray. In another embodiment, the change in composition is achieved by drying of an applied paint or spray. In another embodiment, the change in composition is achieved through a sol-gel reaction. In an embodiment, the superficial layer causing the change in composition is of ceramic nature. In another embodiment, the superficial layer causing the change in composition comprises a ceramic material. In an embodiment, the superficial layer causing the change in composition comprises an oxide. In an embodiment, the superficial layer causing the change in composition comprises a carbide. In an embodiment, the superficial layer causing the change in composition comprises a nitride. In an embodiment, the superficial layer causing the change in composition comprises a boride. In an embodiment, the superficial layer causing the change in composition is of intermetallic nature. In an embodiment, the superficial layer causing the change in composition comprises an intermetallic material. In an embodiment, the superficial layer causing the change in composition comprises a higher % Ti than any of the underlying materials. In an embodiment, the superficial layer causing the change in composition comprises a higher % Cr than any of the underlying materials. In an embodiment, the superficial layer causing the change in composition comprises a higher % Al than any of the underlying materials. In an embodiment, the superficial layer causing the change in composition comprises a higher % Si than any of the underlying materials. In an embodiment, the superficial layer causing the change in composition comprises a higher % Ba than any of the underlying materials. In an embodiment, the superficial layer causing the change in composition comprises a higher % Sr than any of the underlying materials. In an embodiment, the superficial layer causing the change in composition comprises a higher % Ni than any of the underlying materials. In an embodiment, the superficial layer causing the change in composition comprises a higher % V than any of the underlying materials. In an embodiment, when referring to underlying materials it is restricted to any material in direct contact with the layer. In another embodiment, an underlying material is all the materials comprised in the manufactured component. In an embodiment, the superficial layer causing the change in composition is a coating. In an embodiment, oxide coatings are employed, like aluminum, zirconium, lanthanum, calcium, and other white oxides. In an embodiment, dark oxides are employed, like for example titanium. In an embodiment, a coating comprising oxygen and at least one of the following elements: % Cr, % Al, % Si, % Ti, % Y, % La, % Ca, % Zr, % Hf, % Ba, % Sr is employed. In an embodiment, a coating comprising oxygen and at least two of the following elements: % Cr, % Al, % Si, % Ti, % Y, % La, % Ca, % Zr, % Hf, % Ba, % Sr is employed. In an embodiment, nitride coatings are employed. In another embodiment, boride coatings are employed. In an embodiment, a coating comprising nitrogen and at least one of the following elements: % Cr, % Al, % Si, % Ti, % V is employed. In an embodiment, a coating comprising nitrogen and at least two of the following elements: % Cr, % Al, % Si, % Ti, % V is employed. In an embodiment, a coating comprising carbon and at least one of the following elements: % Cr, % Al, % Si, % Ti, % V is employed. In an embodiment, a coating comprising carbon and at least two of the following elements: % Cr, % Al, % Si, % Ti, % V is employed. In an embodiment, a coating comprising boron and at least one of the following elements: % Cr, % Al, % Si, % Ti, % V is employed. In an embodiment, a coating comprising boron and at least two of the following elements: % Cr, % Al, % Si, % Ti, % V is employed. In an embodiment, the coating is based on titanates such as barium or strontium titanates. In an embodiment, at least a part of the working surface is coated with barium titanate. In an embodiment, at least a part of the working surface is coated with strontium titanate. In an embodiment, at least a part of the working surface is coated with a barium-strontium titanate (a mixture of barium and strontium stoichiometric or quasi—stoichiometric titanate). In an embodiment, a morphologically similar coating is employed. In an embodiment, a functionally similar coating material is employed. In an embodiment, a functionally similar material is one where at least two of the following properties of the coating: the elastic modulus, the fracture toughness, the wettability angle of the cast alloy on the coating applied to the chosen tool material where the tool material is kept at 150° C. and the casted alloy 50° C. above its melting temperature, the contact angle hysteresis of the cast alloy on the coating applied to the chosen tool material where the tool material is kept at 150° C. and the casted alloy 50° C. above its melting temperature and electrical resistivity, in different embodiments, is kept within a range of +1-45%, within a range of +/−28%, within a range of +/−18%, within a range of +/−8% and even within a range of +/−4% of the values obtained for barium titanate. In an embodiment, it is at least three of the properties. In another embodiment, it is all four properties. In an embodiment, properties are kept similar to strontium titanate instead of barium titanate. In an embodiment, the surface conditioning comprises a physical modification of at least some of the surface of the manufactured component. In an embodiment, the surface conditioning comprises a change in the surface roughness. In an embodiment, the surface conditioning comprises a change in the surface roughness to an intended level. In an embodiment, the surface conditioning comprises a mechanical operation on the surface. In an embodiment, the surface conditioning comprises a polishing operation. In an embodiment, the surface conditioning comprises a lapping operation. In an embodiment, the surface conditioning comprises an electro-polishing operation. In an embodiment, the surface conditioning comprises a mechanical operation on the surface which also leaves residual stresses on the surface. In an embodiment, at least some of the residual stresses are compressive. In an embodiment, the surface conditioning comprises a shot-penning operation. In an embodiment, the surface conditioning comprises a ball-blasting operation. In an embodiment, the surface conditioning comprises a tumbling operation. One of the aspects where the inventor found more novel aspects in the surface conditioning that can constitute standalone inventions is the one related to surface texture tailoring. In an embodiment, the surface conditioning comprises a texturing operation on the surface. In an embodiment, the surface conditioning comprises a tailored texturing operation on the surface. In an embodiment, the surface conditioning comprises a texturing operation on the surface providing at least two different texturing patterns in different areas of the surface. In an embodiment, the surface conditioning comprises an etching operation. In an embodiment, the surface conditioning comprises a chemical etching operation. In an embodiment, the surface conditioning comprises a beam etching operation. In an embodiment, the surface conditioning comprises an electron-beam etching operation. In an embodiment, the surface conditioning comprises a laser-beam etching operation. In an embodiment, the texturing is done through laser engraving. In an embodiment, the texturing is done through electron-beam engraving. In an embodiment, the surface conditioning comprises both a physical and a chemical modification of at least some of the surface of the manufactured component. In an embodiment, the surface conditioning comprises a coating and a texturing operation on it. In an embodiment, the texturing is made on a chemically modified surface. In an embodiment, the texturing is made on an applied coating. In an embodiment, the engraving is made on an applied coating. In an embodiment, the etching is made on an applied coating.

In some embodiments, when the manufactured component is a metallic component with an embedded ceramic phase, it is interesting to consider this ceramic phase as a metallic part with respect to the % NMVS, the percentage of reduction of NMVS, the % NMVC, the percentage of reduction of NMVC, the apparent density and the percentage of increase of the apparent density. In some cases, when the manufactured component is a metallic component comprising a ceramic phase, it is interesting to consider this ceramic phase as a metallic part with respect to the % NMVS, the percentage of reduction of NMVS, the % NMVC, the percentage of reduction of NMVC, the apparent density and the percentage of increase of the apparent density. Accordingly, in some embodiments, when reference is made to the % NMVS in the metallic part of the component, the percentage of reduction of NMVS in the metallic part of the component, the % NMVC in the metallic part of the component, the % NMVS in the metallic part of the component, the percentage of reduction of NMVS in the metallic part of the component, the % NMVC in the metallic part of the component, the percentage of reduction of NMVC in the metallic part of the component, the apparent density of the metallic part of the component and/or the percentage of increase of the apparent density of the metallic part of the component and/or the percentage of increase of apparent density of the metallic part of the component, the wording “metallic part of the component” can be replaced by “inorganic part of the component”.

As previously disclosed, for certain applications, it is advantageous to manufacture the component (or at least the part of the component manufactured using the methods disclosed in preceding paragraphs) using different materials. In such cases, in some embodiments, when reference is made to the content of certain elements in the metallic part of the component, the wording “in the metallic part of the component” can be replaced by “in at least one material comprised in the component”.

In an embodiment, the component obtained with the methods disclosed above has a complex geometry. In an embodiment, the component is a tool. In another embodiment, the component is a tool made of steel. In another embodiment, the component is a tool comprising a steel. In another embodiment, the component is a die. In another embodiment, the component is a die casting die. In another embodiment, the component is a plastic injection mold. In another embodiment, the component is a hot stamping die. In another embodiment, the component is a forging die. In another embodiment, the component is an extrusion die. In another embodiment, the component is a cold work die. In another embodiment, the component is a drawing and/or bending die. In another embodiment, the component is a sheet forming die. In another embodiment, the component is a cutting die. In another embodiment, the component is a fiber drawing die. In another embodiment, the component is a composite drawing die. In another embodiment, the component is a composite forming die. In another embodiment, the component is a die to conform carbon fiber reinforced polymer (CFRP).

The components or parts of components manufactured with the methods disclosed in the preceding paragraphs can reach high values of mechanical strength. In different embodiments, the mechanical strength of the component is higher than 730 MPa, higher than 1055 MPa, higher than 1355 MPa and even higher than 2010 MPa. In an embodiment, the values of mechanical strength are at room temperature. In an embodiment, mechanical strength is measured according to ASTM E8/8M-16a. Regarding the elongation, high values can also be reached. In different embodiments, the elongation is higher than 4%, higher than 10.1% and even higher than 21%. In an embodiment, the values of elongation are the values of elongation at break measured at room temperature. In an embodiment, elongation is the elongation at break measured according to ASTM E8/8M-16a. For some applications, components with high toughness can also be obtained. In different embodiments, the toughness of the component is higher than 11 J CVN, higher than 16 J CVN, higher than 26 J CVN, higher than 55 J CVN and even higher than 116 J CVN. In an embodiment, the values of toughness disclosed above are measured at room temperature. In an embodiment, the toughness is measured according to ASTM E23—18 Standard Test Methods for Notched Bar Impact. In an embodiment, the values of toughness are within at least 20 mm from the surface of the component.

As previously disclosed, for some applications, the methods disclosed above are particularly advantageous in combination with the “proper geometrical design strategy” as previously defined in this document. Accordingly, all the embodiments that relates to a “proper geometrical design strategy” disclosed in this document can be combined with the methods disclosed above in any combination, provided that they are not mutually exclusive.

The methods disclosed in preceding paragraphs can be implemented with variations to the foregoing embodiments that can meet the purpose described above. These embodiments serving the same, equivalent or similar purpose can replace the features disclosed above are all included in the technical scope of the present method, unless otherwise stated.

For some applications, obtaining high toughness related properties in additive manufacturing methods can be quite challenging. Additionally, when using irregular powders attaining high toughness relates properties can also be challenging. The inventor has found that for some applications, this difficulty can be overcome employing the right powder or powder mixture and applying a manufacturing step wherein the apparent density of the component achieved in the forming step is slightly low. In an embodiment, the method comprises the following steps:
providing a powder or powder mixture;
applying an additive manufacturing method;
applying a consolidation method:
and optionally:
applying a high temperature, high pressure treatment.

For certain applications, many additional steps can be included in the method, some of which will be discussed in detail below.

The inventor has found that high performance metal comprising components can be obtained when following the method disclosed above. For some applications, it is advantageous to manufacture a component in different parts that can be assembled together. In an embodiment, the method disclosed above is used to manufacture at least part of a component. On the other hand, in some embodiments, it is advantageous to manufacture the entire component using the method disclosed above. For certain applications, it is advantageous to manufacture the component (or at least the part of the component manufactured using the method disclosed above) using different materials. In an embodiment, the manufactured component comprises at least two different materials. In another embodiment, the manufactured component comprises at least three different materials. In another embodiment, the manufactured component comprises at least four different materials.

The inventor has found that for some applications, this method is particularly advantageous in combination with the “proper geometrical design strategy” as previously defined in this document. Accordingly, any embodiment that relates to a “proper geometrical design strategy” disclosed in this document can be combined with the present method in any combination, provided that they are not mutually exclusive.

For some applications, the method used to manufacture the powder or powder mixture provided has a great relevance in the mechanical properties which can be achieved in the component. The inventor has surprisingly found that, when following the method steps disclosed above, very high performant components can be obtained even when the powder or powder mixture used to manufacture the component comprises a low cost powder, like for example a water atomized powder and/or a powder obtained by oxide reduction. In an embodiment, the powder is a powder obtained by water atomization. In another embodiment, the powder is a powder obtained by oxide reduction. In an embodiment, the powder mixture comprises at least a powder obtained by water atomization. In an embodiment, the powder mixture comprises at least a powder obtained by oxide reduction. Other technologies may also be advantageous to obtain the powder or at least part of the powders contained in the powder mixture. In an embodiment, the powder is obtained by mechanical action. In another embodiment, the powder is mechanically crushed. In an embodiment, the powder mixture comprises at least a powder obtained by mechanical action. In an embodiment, the powder mixture comprises at least a powder mechanically crushed. In an embodiment, the powder mixture comprises at least a powder obtained by attrition. In an embodiment, the powder mixture comprises at least a powder obtained by milling. In an embodiment, the powder mixture comprises at least a powder obtained by ball milling. In an embodiment, the powder mixture comprises at least a powder obtained by kinetic energy breaking. In an embodiment, the powder mixture comprises at least a powder obtained through controlled crushing. In an embodiment, the powder mixture comprises at least a powder obtained by comminution. The inventor has found that for some applications, the use of at least one irregular powder is advantageous. In an embodiment, the powder or powder mixture comprises an irregular powder. In an embodiment, the powder is an irregular powder. In an embodiment, the powder mixture comprises at least one irregular powder. In another embodiment, the powder mixture comprises at least two irregular powders. In an embodiment, an irregular powder is a non-spherical powder. In different embodiments, a non-spherical powder is a powder with a sphericity below 99%, below 89%, below 79%, below 74% and even below 69%. For some applications, the use of powders with very low sphericity is disadvantageous. In different embodiments, a non-spherical powder is a powder with a sphericity above 22%, above 36%, above 51% and even above 64%, The inventor has also found that in some applications, the use of spherical powders is particularly advantageous. In an embodiment, the powder or powder mixture comprises a spherical powder. In an embodiment, the powder mixture comprises a spherical powder. In an embodiment, a spherical powder means a powder obtained by gas atomization, centrifugal atomization and/or a powder rounded with a plasma treatment. In an embodiment, the powder or powder mixture comprises a powder obtained by gas atomization. In an embodiment, the powder or powder mixture comprises at least one powder obtained by centrifugal atomization. In an embodiment, the powder or powder mixture comprises a powder rounded with a plasma treatment. In an embodiment, the powder mixture comprises at least one powder obtained by gas atomization. In an embodiment, the powder mixture comprises at least one powder obtained by centrifugal atomization. In an embodiment, the powder mixture comprises at least one powder obtained rounded with a plasma treatment. In different embodiments, a spherical powder is a powder with a sphericity above 76%, above 82%, above 92%, above 96% and even 100%. The sphericity of the powder refers to a dimensionless parameter defined as the ratio between the surface area of a sphere having the same volume as the particle and the surface area of the particle. In an embodiment, sphericity (Ψ) is calculated using the formula: Ψ=[Π^{1/3}*(6*Vp)^{2/3}]/Ap. In this formula, t refers to the mathematical constant commonly defined as the ratio of a circle's circumference to its diameter, Vp is the volume of the particle and Ap is the surface area of the particle. In an embodiment, the sphericity of the particles is determined by dynamic image analysis. In an alternative embodiment, the sphericity is measured by light scattering diffraction. In an embodiment, the above disclosed for the powder or powder mixture refers to the powder or powder mixture provided.

In an embodiment, the powder or powder mixture comprises a metallic powder. In an embodiment, the powder is a metal comprising powder. In an embodiment the powder mixture is a metal comprising powder mixture. In an embodiment, the powder or powder mixture comprises at least a metal or metal alloy in powdered form. In an embodiment, the powder or powder mixture comprises at least one of the following metal or metal alloys in powdered form: iron or an iron based alloy, a steel, a stainless steel, titanium or a titanium based alloy, aluminium or an aluminium based alloy, magnesium or a magnesium based alloy, nickel or a nickel based alloy, copper or a copper based alloy, niobium or a niobium based alloy, zirconium or a zirconium based alloy, silicon or a silicon based alloy, chromium or a chromium based alloy, cobalt or a cobalt based alloy, molybdenum or a molybdenum based alloy, manganese or a manganese based alloy, tungsten or a tungsten based alloy, lithium or a lithium based alloy, tin or a tin based alloy, tantalum or a tantalum based alloy and/or mixtures thereof. In an embodiment, the powder or powder mixture comprises a metal or metal based alloy powder. In an embodiment, the powder or powder mixture comprises a metal based alloy powder. In an embodiment, the powder mixture comprises at least one metal based alloy powder. In an embodiment, the powder mixture comprises at least one metal or metal based alloy powder. In an embodiment, the powder mixture comprises at least one critical powder (as previously defined) which is a metal based alloy powder. In an embodiment, the powder mixture comprises at least one critical powder (as previously defined) which is a metal or metal based alloy powder. In an embodiment, the powder mixture comprises at least a relevant powder (as previously defined) which is a metal based alloy powder. In an embodiment, the powder mixture comprises at least a relevant powder (as previously defined) which is a metal or metal based alloy powder. For certain applications, the use of a metal alloy powder or a powder mixture having an overall composition corresponding to that of a metal based alloy is preferred. In an embodiment, the powder is a metal based alloy powder. In an embodiment, the powder is a metal or metal based alloy powder. In an embodiment, the powder mixture has a mean composition corresponding to that of a metal based alloy. In an embodiment, the powder mixture has a mean composition corresponding to that of a metal or metal based alloy. In an embodiment, the metal is iron. In an embodiment, the metal is titanium. In an embodiment, the metal is aluminium. In an embodiment, the metal is magnesium. In an embodiment, the metal is nickel. In an embodiment, the metal is copper. In an embodiment, the metal is niobium. In an embodiment, the metal is zirconium. In an embodiment, the metal is silicon. In an embodiment, the metal is chromium. In an embodiment, the metal is cobalt. In an embodiment, the metal is molybdenum. In an embodiment, the metal is manganese. In an embodiment, the metal is a tungsten. In an embodiment, the metal is lithium. In an embodiment, the metal is tin. In an embodiment, the metal is tantalum. For certain applications, the use of mixtures of the above disclosed metal or metal based alloys is preferred. The composition of the powder or powder mixture is not limited to the use of these metal or metal alloys, however. Accordingly, any other powder or powder mixture comprising at least a metal or a metal based alloy can also be used. In some embodiments, the powders and/or powder mixtures disclosed in patent application number PCT/EP2019/075743, the contents of which are incorporated herein by reference in their entirety may be advantageously used. For some applications, the use of any of the powders or powder mixtures disclosed throughout this document is particularly advantageous. In this regard, the inventor has found that for some applications, the use of a nitrogen austenitic steel (a nitrogen austenitic steel with the composition previously disclosed is this document) in powdered form is surprisingly advantageous. In an embodiment, the powder or powder mixture comprises a nitrogen austenitic steel powder. In an embodiment, the powder mixture comprises at least one nitrogen austenitic steel powder. For certain applications, the use of a nitrogen austenitic steel powder or a powder mixture having an overall composition corresponding to that of a nitrogen austenitic steel is preferred. In an embodiment, the powder is a nitrogen austenitic steel powder. In an embodiment, the powder mixture has a mean composition corresponding to that of a nitrogen austenitic steel. In some embodiments, the use of powder or powder mixtures according to the mixing strategies previously defined in this document. Accordingly, all the embodiments related to the powders or powders mixtures disclosed in the mixing strategies can be combined with the present method in any combination. In an embodiment, the powder mixture comprises at least a LP and SP powder (as previously defined in the mixing strategy). In an embodiment, the powder or powder mixture comprises a LP powder (as previously defined). In an embodiment, the powder or powder mixture comprises a SP powder (as previously defined). In an embodiment, the powder or powder mixture comprises at least a powder P1, P2. P3 and/or P4 (as previously defined). For some applications, the use of powders comprising % Y, % Sc. % REE, % Al and/or % Ti is surprisingly advantageous. In some embodiments, the use of a powder or powder mixture comprising % Y. % Sc, and/or % REE (with the % Y, % Sc, and/or % REE contents disclosed through this document) is particularly advantageous. In an embodiment, the powder or powder mixture comprises the right content of % Y+% Sc+% REE, being % REE as previously defined. In an embodiment, the powder mixture comprises at least one powder with the right content of % Y+% Sc+% REE, being % REE as previously defined. For some applications, the use of a powder or powder mixture comprising % Y, % Sc, % REE and/or % Al is preferred. In an embodiment, the powder or powder mixture comprises the right content of % A+% Y+% Sc+% REE, being % REE as previously defined. In an embodiment, the powder mixture comprises at least one powder with the right content of % Al+% Y+% Sc+% REE, being % REE as previously defined. For some applications, the use of a powder or powder mixture comprising % Y, % Sc, % REE and/or % Ti is preferred. In an embodiment, the powder or powder mixture comprises the right content of % Ti+% Y+% Sc+% REE, being % REE as previously defined. In an embodiment, the powder mixture comprises at least one powder with the right content of % Ti+% Y+% Sc+% REE, being % REE as previously defined. For some applications, the use of a powder or powder mixture comprising % Y, % Sc, % REE, % Al and/or % Ti is advantageous. In an embodiment, the powder or powder mixture comprises the right content of % Al+% Ti+% Y+% Sc+% REE, being % REE as previously defined. In an embodiment, the powder mixture comprises at least one powder with the right content of % Al+% Ti+% Y+% Sc+% REE, being % REE as previously defined. In different embodiments, the right content is 0.012 wt % or more, 0.052 wt % or more, 12 wt % or more, 0.22 wt % or more, 0.42 wt % or more and even 0.82 wt % or more. For certain applications, an excessive content is detrimental to mechanical properties. In different embodiments, the right content is 6.8 wt % or less, 3.9 wt % or less, 1.4 wt % or less, 0.96 wt % or less, 0.74 wt % or less and even 0.48 wt % or less. Very surprisingly, for some applications, it is possible to attain extraordinary mechanical properties by using systems comprising powders comprising % Y, % Sc, % REE and/or % Ti. For some applications, it is very important to select a very precise level of % Ti, % Y, % Sc and/or % REE and for those applications the concept of yttrium equivalent is very interesting. Unless otherwise stated, the feature “right level of % Yeq(1)” is defined throughout the present document in the form of different alternatives, that are explained in detail below. In an embodiment, the following concept of yttrium equivalent is employed: % Yeq(1)=% Y+1.55*(% Sc+% Ti)+0.68%*REE, being % REE as previously defined. In different embodiments, the level of % Yeq(1) has to be higher than 0.03 wt %, higher than 0.06 wt %, higher than 0.12 wt %, higher than 0.6 wt %, higher than 1.2 wt %, higher than 2.1 wt % and even higher than 3.55 wt %. For certain applications, excessively high levels may be detrimental to mechanical properties. In different embodiments, the level of % Yeq(1) has to be lower than 8.9 wt %, lower than 4.9 wt %, lower than 3.9 wt %, lower than 2.9 wt %, lower than 2.4 wt %, lower than 1.9 wt %, lower than 1.4 wt %, lower than 0.9 wt % and even lower than 0.4 wt %. In an alternative embodiment, what has been disclosed above in this paragraph as well as the definition of % Yeq(1) are modified to ignore % Ti, so that the % Ti contained in the material is not taken into account for the calculations of % Yeq(1). In an embodiment, the powder or powder mixture comprises the right level of % Yeq(1). In another embodiment, at least one of the powders in the powder mixture comprises the right level of % Yeq(1). In another embodiment, the metallic part of the component comprises the right level of % Yeq(1) at some point during the application of the method. In another embodiment, the metallic part of the manufactured component comprises the right level of % Yeq(1). In another embodiment, at least one of the materials comprised in the manufactured component comprises the right level of % Yeq(1). For some applications, a certain relation of the oxygen content to the content of % Y. % Sc, % Ti and % REE is advantageous. In an embodiment, the % O content is chosen to comply with the following formula % O≤KYS*(% Y+1.98*% Sc+2.47*% Ti+0.67*% REE), being % REE as previously defined. In another embodiment, the % O content is chosen to comply with the following formula KYI*(% Y+1.98*% Sc+2.47*% Ti+0.67*% REE)<% O≤KYS*(% Y+1.98*% Sc+2.47%*Ti+0.67*% REE), being % REE as previously defined. In different embodiments, KYI is 3800, 2900, 2700, 2650, 2600, 2400, 2200, 2000 and even 1750. In different embodiments, KYS is 2100, 2350, 2700, 2750, 2800, 3000, 3500, 4000, 4500 and even 8000. In an alternative embodiment, what has been disclosed above in this paragraph is modified to ignore % Ti, so that the % Ti contained in the material is not taken into account for the calculations of acceptable % O. In an embodiment the content of % O, % Y, % Sc, % Ti and % REE refers to the content of % O, % Y. % Sc, % Ti and % REE in the powder or powder mixture. In another embodiment the content of % O, % Y, % Sc, % Ti and % REE refers to the content of % O, % Y, % Sc, % Ti and % REE in at least one of the powders in the powder mixture. The inventor has found that for some applications, very high mechanical properties especially in terms of yield strength combined with elongation can be reached when the powder mixture provided comprises at least one powder with the proper level of % V, % Nb, % Ta, % Ti, % Mn, % Al, % Si, % Moeq and/or % Cr (the proper levels as disclosed below). In an embodiment, the powder mixture comprises at least one powder with the proper level of % V. % Nb, % Ta and/or % Ti. In an embodiment, the powder mixture comprises at least one powder with the proper level of % Mn. In an embodiment, the powder mixture comprises at least one powder with the proper level of % Al and/or % Si. In an embodiment, the powder mixture comprises at least one powder with the proper level of % Moeq (% Moeq=% Mo+½*% W). In an embodiment, the powder mixture comprises at least one powder with the proper level of % Cr. In different embodiments, the proper level is more than 8 wt %, more than 21 wt %, more than 41 wt % and even more than 51 wt %. For certain applications, excessively high levels may be detrimental. In different embodiments, the proper level is less than 89 wt %, less than 79 wt % and even less than 69 wt %. For certain applications, the content of % V+% Al+% Cr+% Mo+% Ta+% W+% Nb in the powder or powder mixture is relevant to the mechanical properties which can be achieved in the component. In different embodiments, a right level of % V+% Al+% Cr+% Mo+% Ta+% W+% Nb is 0.12 wt % or more, 0.6 wt % or more, 1.1 wt % or more, 2.1 wt % or more, 3.1 wt % or more, 5.6 wt % or more and even 11 wt % or more. For certain applications, excessively high levels may be detrimental to mechanical properties. In different embodiments, a right level of % V+% Al+% Cr+% Mo+% Ta+% W+% Nb is 34 wt % or less, 29 wt % or less, 19 wt % or less, 9 wt % or less and even 4 wt % or less. In an embodiment, the powder or powder mixture comprises a right level of % V+% Al+% Cr+% Mo+% Ta+% W+% Nb. In another embodiment, the powder mixture comprises at least one powder with a right level of % V+% Al+% Cr+% Mo+% Ta+% W+% Nb. The inventor has found that some applications benefit from the use of powder mixtures comprising pure iron, carbonyl iron, graphite and/or mixtures thereof. In an embodiment, the powder mixture comprises carbon. In an embodiment, the powder mixture comprises carbon in graphite form. In an embodiment, the carbon is constituted to at least 52% graphite. In an embodiment, the powder mixture comprises synthetic graphite. In an embodiment, the carbon is constituted to at least 52% synthetic graphite. In an embodiment, the powder mixture comprises carbon in natural graphite form. In an embodiment, the carbon is constituted to at least 52% natural graphite. In an embodiment, the powder mixture comprises carbon in fullerene form. In an embodiment, the carbon is constituted to at least 52% of fullerene carbon. In an embodiment, the powder mixture comprises carbonyl iron. In an embodiment, the powder or powder mixture comprises a powder of pure iron. In an embodiment, the powder or powder mixture comprises a powder of atomized pure iron. In an embodiment, the powder or powder mixture comprises a powder of atomized pure iron which is mainly spherical. In an embodiment, the powder or powder mixture comprises a powder of atomized pure iron which is spherical. In an embodiment, the powder or powder mixture comprises a powder of pure iron obtained by gas atomization. In an embodiment, the powder or powder mixture comprises a powder of pure iron obtained by centrifugal atomization. In an embodiment, the powder or powder mixture comprises a pure iron powder. In an embodiment, the powder or powder mixture comprises a powder of iron and impurities. In an embodiment, the powder or powder mixture comprises a powder of iron, carbon and impurities. In an embodiment, the powder or powder mixture comprises a powder of iron, carbon, nitrogen and impurities. In an embodiment, the powder or powder mixture comprises a powder which is iron and trace elements. In different embodiments, trace elements are 0.9 wt % or less, 0.4 wt % or less, 0.18 wt % or less and even 0.08 wt % or less. Surprisingly, the inventor has found that components with good mechanical properties and high levels of performance can be achieved when the powder or the powder mixture employed has a proper oxygen (% O) content. Unless otherwise stated, the feature “proper oxygen content” is defined throughout the present document in the form of different alternatives that are explained in detail below. In different embodiments, a proper oxygen content is an oxygen content of more than 250 ppm, of more than 410 ppm, of more than 620 ppm, of more than 1100 ppm, of more than 1550 ppm and even of more than 2100 ppm. All expressed in wt %. For some applications, at least some powders are selected with a high but not extremely high oxygen content. In different embodiments, a proper oxygen content is an oxygen content of more than 2550 ppm, of more than 4500 ppm, of more than 5100 ppm and even of more than 6100 ppm. All expressed in wt %. For some applications, an excessive content of oxygen may be detrimental to the mechanical properties of the manufactured component. In different embodiments, a proper oxygen content is an oxygen content of less than 48000 ppm, of less than 19000 ppm, of less than 14000 ppm and even of less than 9900 ppm. All expressed in wt %. For some applications, lower contents are preferred. In different embodiments, a proper oxygen content is an oxygen content of less than 9000 ppm, of less than 6900 ppm, of less than 4900 ppm, of less than 2900 ppm and even of less than 900 ppm. All expressed in wt %. In an embodiment, the powder has a proper oxygen content. In another embodiment, the powder mixture comprises at least one powder with a proper oxygen content. In another embodiment, the powder mixture comprises at least two powders with a proper oxygen content. In another embodiment, the powder mixture comprises at least three powders with a proper oxygen content. In another embodiment, the powder mixture has a proper oxygen content. In some embodiments, it is particularly advantageous when the powder (or at least one of the powders in the powder mixture) is a powder obtained by water atomization with a proper oxygen content (as previously defined). Alternatively, in some embodiments, it is particularly advantageous when the powder (or at least one of the powders in the powder mixture) is a powder obtained by oxide reduction with a proper oxygen content (as previously defined). All the embodiments disclosed above can be combined among them in any combination, provided that they are not mutually exclusive, for example: in an embodiment, the oxygen content of the powder or powder mixture is above 250 ppm and below 48000 ppm; or for example: in another embodiment, the oxygen content of the powder is above 410 ppm and below 14000 ppm. For some applications, the level of nitrogen (% N) in the powder or powder mixture is very relevant. The inventor has found that components with good mechanical properties and high levels of performance can be achieved when the powder or the powder mixture employed has a proper nitrogen (% N) content. Unless otherwise stated, the feature “proper nitrogen content” is defined throughout the present document in the form of different alternatives that are explained in detail below. In different embodiments, a proper nitrogen content is a nitrogen content of more than 12 ppm, of more than 55 ppm, of more than 110 ppm and even of more than 220 ppm. For some applications, excessive content of nitrogen should be avoided. In different embodiments, a proper nitrogen content is a nitrogen content of less than 9000 ppm, of less than 900 ppm, of less than 490 ppm, of less than 190 ppm and even of less than 90 ppm. In an embodiment, the powder is a powder with a proper nitrogen content. In another embodiment, the powder mixture comprises at least one powder with a proper nitrogen content. In another embodiment, the powder mixture comprises at least two powders with a proper nitrogen content. In another embodiment, the powder mixture comprises at least three powders with a proper nitrogen content. In another embodiment, the powder mixture has a proper nitrogen content. All the embodiments disclosed above can be combined among them in any combination, provided that they are not mutually exclusive, for example: in an embodiment, the nitrogen content of the powder or powder mixture is above 12 ppm and below 9000 ppm; or for example: in another embodiment, the nitrogen content of the powder is above 12 ppm and below 900 ppm. For some applications, it has been found to be advantageous to admix a nitrogen comprising material in the powder o powder mixture. In an embodiment, a nitrogen comprising material is admixed in the powder or powder mixture. In an embodiment, the amount of nitrogen comprising material is selected in terms of total weight % of nitrogen in the manufactured component. In another embodiment, the amount of nitrogen comprising material is selected in terms of total weight % of nitrogen in at least one of the materials comprised in the manufactured component. In another embodiment, the amount of nitrogen comprising material is selected in terms of total weight % of nitrogen in the material after the mixing is made. In an embodiment, the amount of nitrogen comprising material is selected so as to have 0.02 wt % or more nitrogen. In another embodiment, the amount of nitrogen comprising material is selected so as to have 0.12 wt % or more nitrogen. In another embodiment, the amount of nitrogen comprising material is selected so as to have 0.22 wt % or more nitrogen. In another embodiment, the amount of nitrogen comprising material is selected so as to have 0.41 wt % or more nitrogen. In another embodiment, the amount of nitrogen comprising material is selected so as to have 0.52 wt % or more nitrogen. In another embodiment, the amount of nitrogen comprising material is selected so as to have 0.76 wt % or more nitrogen. In another embodiment, the amount of nitrogen comprising material is selected so as to have 1.1 wt % or more nitrogen. In another embodiment, the amount of nitrogen comprising material is selected so as to have 2.1 wt % or more nitrogen. For certain applications, excessively high contents should be avoided. In an embodiment, the amount of nitrogen comprising material is selected so as to have 3.9 wt % or less nitrogen. In another embodiment, the amount of nitrogen comprising material is selected so as to have 2.9 wt % or less nitrogen. In another embodiment, the amount of nitrogen comprising material is selected so as to have 1.9 wt % or less nitrogen. In another embodiment, the amount of nitrogen comprising material is selected so as to have 1.4 wt % or less nitrogen. In another embodiment, the amount of nitrogen comprising material is selected so as to have 0.9 wt % or less nitrogen. In another embodiment, the amount of nitrogen comprising material is selected so as to have 0.69 wt % or less nitrogen. In another embodiment, the amount of nitrogen comprising material is selected so as to have 0.49 wt % or less nitrogen. For some applications, the use of a higher nitrogen content is preferred. In different embodiments, a higher nitrogen content means a content which is at least 10% more, at least 15% more, at least 20% more, at least 50% more and even 200% more. In an embodiment, the nitrogen comprising material is a nitride and/or a mixture of nitrides. For some applications, the use of carbo-nitrides, chromium nitrides, iron nitrides, molybdenum nitrides, tungsten nitrides, vanadium nitrides, niobium nitrides, tantalum nitrides, titanium nitrides and/or mixtures thereof is advantageous. In an embodiment, the nitrogen comprising material is a carbo-nitride. In an embodiment, the nitrogen comprising material comprises a carbo-boro-oxo-nitride. In an embodiment, the nitrogen comprising material comprises a carbo-nitride. In an embodiment, the nitrogen comprising material comprises a carbo-boro-oxo-nitride where carbon, boron and/or oxygen can be missing. In an embodiment, the nitrogen comprising material comprises a carbo-boro-oxo-nitride where carbon, boron and/or oxygen can be missing which is stable under standard conditions. In an embodiment, the nitrogen comprising material comprises a carbo-boro-oxo-nitride where carbon, boron and/or oxygen can be missing which is stable at 800° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 900° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 1000° C. under standard pressure in an argon atmosphere with 0.5 ppm oxygen. In an embodiment, the nitrogen comprising material comprises a carbo-boro-oxo-nitride where carbon, boron and/or oxygen can be missing which is stable at 1100° C. under standard pressure in an argon atmosphere with 0.5 ppm oxygen. In an embodiment, the nitrogen comprising material comprises a carbo-boro-oxo-nitride where carbon, boron and/or oxygen can be missing and which also comprises % Cr. In an embodiment, the nitrogen comprising material comprises a chromium nitride which is stable under standard conditions. In an embodiment, the nitrogen comprising material comprises a chromium nitride which is stable at 800° C. under standard pressure in an argon atmosphere with 0.5 ppm oxygen. In an embodiment, the nitrogen comprising material comprises a chromium nitride which is stable at 900° C. under standard pressure in an argon atmosphere with 0.5 ppm oxygen. In an embodiment, the nitrogen comprising material comprises a chromium nitride which is stable at 1000° C. under standard pressure in an argon atmosphere with 0.5 ppm oxygen. In an embodiment, the nitrogen comprising material comprises a chromium nitride which is stable at 1100° C. under standard pressure in an argon atmosphere with 0.5 ppm oxygen. In an embodiment, the nitrogen comprising material comprises the right chromium nitride content. In different embodiments, the right chromium nitride content is 0.094 wt % or more, 0.94 wt % or more, 1.4 wt % or more, 1.9 wt % or more, 2.9 wt % or more, 4.3 wt % or more and even 5.6% or more. For certain applications, excessively high contents may be detrimental. In different embodiments, the right chromium nitride content is 18.3 wt % or less, 13.6 wt % or less, 8.9 wt % or less, 6.6 wt % or less and even 4.2 wt % or less. In an embodiment, the nitrogen comprising material comprises a carbo-boro-oxo-nitride where carbon, boron and/or oxygen can be missing and which also comprises % Fe. In an embodiment, the nitrogen comprising material comprises an iron nitride which is stable under standard conditions. In an embodiment, the nitrogen comprising material comprises a carbo-boro-oxo-nitride where carbon, boron and/or oxygen can be missing and which also comprises % Mo. In an embodiment, the nitrogen comprising material comprises a molybdenum nitride which is stable under standard conditions. In an embodiment, the nitrogen comprising material comprises a carbo-boro-oxo-nitride where carbon, boron and/or oxygen can be missing and which also comprises % W. In an embodiment, the nitrogen comprising material comprises a tungsten nitride which is stable under standard conditions. In an embodiment, the nitrogen comprising material comprises a carbo-boro-oxo-nitride where carbon, boron and/or oxygen can be missing and which also comprises % V. In an embodiment, the nitrogen comprising material comprises a vanadium nitride which is stable under standard conditions. In an embodiment, the nitrogen comprising material comprises a carbo-boro-oxo-nitride where carbon, boron and/or oxygen can be missing and which also comprises % Nb. In an embodiment, the nitrogen comprising material comprises a niobium nitride which is stable under standard conditions. In an embodiment, the nitrogen comprising material comprises a carbo-boro-oxo-nitride where carbon, boron and/or oxygen can be missing and which also comprises % Ti. In an embodiment, the nitrogen comprising material comprises a titanium nitride which is stable under standard conditions.

The powder or powder mixture is then formed by applying an additive manufacturing (AM) technology. Alternatively, in some embodiments, a non-additive manufacturing technology can be applied to form the component. In an embodiment, the AM technology comprises forming the component layer-by-layer. In some embodiments, the AM technology employed in the forming step comprises the use of an organic material (such as, but not limited to, a polymer and/or a binder and/or mixtures thereof). The organic materials which can be used is not particularly limited. In an embodiment, the organic material comprises a thermosetting polymer. In an embodiment, the organic material comprises a thermoplastic polymer. In some embodiments, the use of the organic materials disclosed throughout this document may be also advantageous. Non-limiting examples of the AM methods that can be used are: fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), selective laser sintering (SLS), selective heat sintering (SHS), direct energy deposition (DeD), big area additive manufacturing (BAAM), direct metal laser melting (DMLS), selective laser melting (SLM), electron beam melting (EBM), Joule printing, and/or combinations thereof. In an embodiment, the AM method applied in the forming step is selected from: fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), selective laser sintering (SLS), selective heat sintering (SHS), direct energy deposition (DeD), big area additive manufacturing (BAAM) and/or combinations thereof. In another embodiment, the AM method applied in the forming step is selected from: direct metal laser melting (DMLS), selective laser melting (SLM), electron beam melting (EBM), selective laser sintering (SLS), direct energy deposition (DeD), big area additive manufacturing (BAAM), Joule printing, and/or combinations thereof. In an embodiment, the AM method comprises form the component layer by layer. In an embodiment, the AM technology comprises the use of a metallic filament or wire. In an embodiment, the AM method comprises the use of a filament or wire comprising a mixture of an organic material and the powder or powder mixture. In an embodiment, the AM method comprises fuse at least part of the organic material in the filament or wire. In an embodiment, the AM method comprises fuse at least part of the metallic material in the filament or wire. In an embodiment, the AM method applied in the forming step is SLS. In another embodiment, the AM method applied in the forming step is DLS. In another embodiment, the AM method applied in the forming step is a technology based on CLIP. In another embodiment, the AM method applied in the forming step is a DLS based on CLIP. In another embodiment, the AM method applied in the forming step is DMLS. In another embodiment, the AM method applied in the forming step is Joule printing. In another embodiment, the AM method applied in the forming step is SLM. In another embodiment, the AM method applied in the forming step is MJ. In another embodiment, the AM method applied in the forming step is MJF. In another embodiment, the AM method applied in the forming step is BJ. In another embodiment, the AM method applied in the forming step is DOD. In another embodiment, the AM method applied in the forming step is SLA. In another embodiment, the AM method applied in the forming step is DLP. In another embodiment, the AM method applied in the forming step is CDLP. In another embodiment, the AM method applied in the forming step is FDM. In another embodiment, the AM method applied in the forming step is FFF. In another embodiment, the AM method applied in the forming step is a FDM method where the filament or wire employed comprises a mixture of an organic material and the powder mixture. In another embodiment, the AM method applied in the forming step is a FFF method where the filament or wire employed comprises a mixture of an organic material and the powder mixture. In another embodiment, the AM method applied in the forming step is SHS. In another embodiment, the AM method applied in the forming step is EBM. In another embodiment, the AM method applied in the forming step is DeD. In another embodiment, the AM method applied in the forming step is Joule printing. In another embodiment, the AM method applied in the forming step is a DeD method, where the melting source is a laser. In another embodiment, the AM method applied in the forming step is a DeD method, where the melting source is an electron beam. In another embodiment, the AM method applied in the forming step is a DeD method, where the melting source is an electric arc. In another embodiment, the AM method applied in the forming step is BAAM. In another embodiment, the AM method applied in the forming step is a BAAM method, where deposition is achieved through a system resembling a FDM, and where the filament or wire is a mixture of an organic material and a powder or a powder mixture. In another embodiment, the AM method applied in the forming step is a BAAM method, where deposition is achieved through a system resembling a FDM, and where the filament or wire is a mixture of an organic material and a metallic powder or a metal comprising powder mixture. In another embodiment, the AM method applied in the forming step is a BAAM method, where the component build process is made by means of adhesive bonding of the organic material. In another embodiment, the AM method applied in the forming step is a BAAM method, where the component build process does not involve fusion of metallic particles. In another embodiment, the AM method applied in the forming step is a BAAM method, where deposition is achieved through at least a printer head that projects a powder or powder mixture and an organic material. In another embodiment, the AM method applied in the forming step is a BAAM method, where deposition is achieved through at least one printer head that projects the powder or powder mixture and the organic material separately. In another embodiment, the AM method applied in the forming step is a BAAM method, where deposition is achieved through a system resembling a cold spray system. In another embodiment, the AM method applied in the forming step is a BAAM method, where deposition is achieved by high velocity projection of a powder or powder mixture. In another embodiment, the AM method applied in the forming step is a BAAM method, where deposition is achieved by high velocity projection of a mixture of organic particles and metallic and/or ceramic particles. In another embodiment, the AM method applied in the forming step is a BAAM method, where at least part of the metallic particles are fused during the component build process. In another embodiment, the AM method applied in the forming step is a BAAM method, where all the metallic particles are fused during the component build process. In an embodiment, the metallic particles are added in powder form. In another embodiment, the metallic particles are added in a filament or wire form. In another embodiment, the AM method applied in the forming step is a BAAM method, where the heat source is radiation. In another embodiment, the AM method applied in the forming step is a BAAM method, where the heat source is an infrared heat source. In another embodiment, the AM method applied in the forming step is a BAAM method, where the heat source is an ultrasound source. In another embodiment, the AM method applied in the forming step is a BAAM method, where the heat source is a laser. In another embodiment, the AM method applied in the forming step is a BAAM method, where the heat source is a microwave radiation source/microwave generator. In another embodiment, the AM method applied in the forming step is a BAAM method, where the heat source is an electron beam. In another embodiment, the AM method applied in the forming step is a BAAM method, where the heat source is an electric arc. In another embodiment, the AM method applied in the forming step is a BAAM method, where the heat source is plasma. The method is not limited to the use of these AM methods, however. In some embodiments, the use of at least two different AM methods is preferred.

The inventor has found that very surprisingly, for some applications, mechanical performance of the manufactured component can be highly improved when the metallic part of the component after applying the AM method in the forming step has a slightly lower apparent density than foreseeable. In different embodiments, the apparent density of the metallic part of the component after applying the forming step is less than 99.98%, less than 99.8%, less than 98.4%, less than 96.9% and even less than 93.9%. For some applications, even lower apparent densities are preferred. In different embodiments, the apparent density of the metallic part of the component after applying the forming step is less than 91.8%, less than 89.8%, less than 79.8%, less than 69% and even less than 59%. For some applications, excessively low apparent densities often lead to unsatisfactory mechanical performance of the manufactured components. In different embodiments, the apparent density of the metallic part of the component after applying the forming step is higher than 21%, higher than 31%, higher than 41%, higher than 51%, higher than 71% and even higher than 81%. For some applications, even higher apparent densities are advantageous. In different embodiments, the apparent density of the metallic part of the component after applying the forming step is higher than 86%, higher than 91%, higher than 94%, higher than 97% and even higher than 99.1%. The inventor has found that for some applications, there is a certain relation between the apparent density of the metallic part of the component after applying the forming step and the AM process temperature employed in the forming step. Unless otherwise stated, the feature “AM temperature” is defined throughout the present document in the form of different alternatives that are explained in detail below. In an embodiment, the AM process temperature is the maximum temperature. In an alternative embodiment, the AM process temperature is the mean shaping temperature. In another alternative embodiment, the AM process temperature is the mean printing temperature. In another alternative embodiment, the AM process temperature is the minimum printing/shaping temperature. For some applications, the feature “AM process temperature” used throughout this document is defined in accordance with any of the embodiments described above. Accordingly, all the embodiments disclosed above can be combined among them and with any other embodiment disclosed in this document that relates to the “AM process temperature” in any combination, provided that they are not mutually exclusive. For some applications, the AM process temperature employed in the forming step is preferred below the reference temperature. Unless otherwise stated, the feature “reference temperature” is defined throughout the present document in the form of different alternatives that are explained in detail below. In different embodiments, the reference temperature is 0.36*Tm, 0.41*Tm, 0.46*Tm, 0.5*Tm, 0.59*Tm and even 0.64*Tm, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm refers to the melting temperature of a powder mixture (as previously defined). For some applications, when only one metallic powder is used, Tm is the melting temperature of the metallic powder. In this context, the temperatures disclosed above are in kelvin. For some applications, the feature “reference temperature” used throughout this document is defined in accordance with any of the embodiments described above. Accordingly, all the embodiments disclosed above can be combined among them and with any other embodiment disclosed in this document that relates to the “reference temperature” in any combination, provided that they are not mutually exclusive. In different embodiments, when the AM process temperature employed in the forming step is below the reference temperature, the apparent density of the metallic part of the component after applying the forming step is less than 99.8%, less than 89.8%, less than 79.8%, less than 69% and even less than 59%. For some applications, excessively low apparent densities often lead to unsatisfactory mechanical performance of the manufactured components. In different embodiments, when the “AM process temperature” (as previously defined) employed in the forming step is below the “reference temperature” (as previously defined), the apparent density of the metallic part of the component after applying the forming step is higher than 21%, higher than 31%, higher than 41%, higher than 51%, higher than 71%, higher than 81% and even higher than 86%, The above disclosed about the apparent density of the metallic part of the component after applying the forming step when the “AM process temperature” (as previously defined) employed in the forming step is below the “reference temperature” (as previously defined) may also be applied to the AM methods comprising the use of an organic material. In some other applications, the “AM process temperature” (as previously defined) employed in the forming step is preferred equal to or above the “reference temperature” (as previously defined). In different embodiments, when the “AM process temperature” (as previously defined) employed in the forming step is equal to or above the “reference temperature” (as previously defined), the apparent density of the metallic part of the component after applying the forming step is less than 99.98%, less than 98.4%, less than 96.9%, less than 93.9%, less than 91.8% and even less than 89.8%. For some applications, excessively low apparent densities often lead to unsatisfactory mechanical performance of the manufactured components. In different embodiments, when the “AM process temperature” (as previously defined) employed in the forming step is equal to or above the “reference temperature” (as previously defined), the apparent density of the metallic part of the component after applying the forming step is higher than 71%, higher than 86%, higher than 91%, higher than 94%, higher than 97% and even higher than 99.1%. In an embodiment, the apparent density=(real density/theoretical density)*100. In an embodiment, the real density of the component is measured by the Archimedes' Principe. In an alternative embodiment, the real density of the component is measured by the Archimedes' Principe according to ASTM B962-08. In an embodiment, the density values are at 20° C. and 1 atm. All the embodiments disclosed above can be combined among them in any combination, provided that they are not mutually exclusive, for example: in an embodiment, the apparent density of the metallic part of the component after applying the forming step is higher than 21% and less than 99.98%; or for example: in an embodiment, the apparent density of the metallic part of the component after applying the forming step is higher than 31% and less than 99.98%; or for example: in another embodiment, the AM maximum temperature employed in the forming step is equal to or above 0.36*Tm, being Tm the melting temperature of the metallic powder with the lowest melting point in the powder mixture, and the apparent density of the metallic part of the component after applying the forming step is higher than 71% and less than 99.98%: or for example: in another embodiment, the AM mean shaping temperature employed in the forming step is below 0.64*Tm, being Tm the melting temperature of the metallic powder with the lowest melting point in the powder mixture, and the apparent density of the metallic part of the component after applying the forming step is higher than 31% and less than 99.8%; or for example: in another embodiment, the AM maximum temperature employed in the forming step is below 0.59*Tm, being Tm the melting temperature of the metallic powder provided, and the apparent density of the metallic part of the component after applying the forming step is higher than 31% and less than 99.8%.

For some applications, the percentage of non-metallic voids with access to the surface of the component (hereinafter referred as % NMVS) after applying the forming step is relevant. Throughout the present method, the percentage of non-metallic voids with access to the surface (% NMVS) is calculated as follows: % NMVS=(volume of NMVS/volume of NMVT)*100, wherein the volume of NMVT is the total volume of non-metallic voids in the component. In this context, the volumes are in m. In an embodiment, the non-metallic voids of the component refer to the voids such as, but not limited to, air and/or polymer and/or binder comprised in the metallic part of the component. In an embodiment, the volume of NMVS refers to the volume of voids (such as, but not limited to, air and/or polymer and/or binder) located inside the metallic part of the component with direct access to the surface of the component without crossing a metal part. In an embodiment, the “voids located inside the component with direct access to the surface of the component without crossing a metal part” refers to a geometrical aspect that is located in an interior volume of a component and that is in direct communication with at least one external surface of the component through one exterior opening defined in the external surface of the component. In an embodiment, ceramics are excluded to calculate the volume of voids. In another embodiment, intermetallics are excluded to calculate the volume of voids. In another embodiment, the voids exclude the geometrical aspects that are part of the design of the component, this means that for example, if the component comprises a cooling channel, void or cavity which is part of the design of the component, this geometrical aspect is not considered to calculate the volume of voids. In an embodiment, voids comprise porosity. In another embodiment, voids comprise only porosity. In some embodiments, the volume of the voids is relevant. In an embodiment, the voids having a volume which is above the volume of the component *10⁻² are not considered to calculate the volume of voids. In another embodiment, the voids having a volume which is above the volume of the component*10⁻³ are not considered to calculate the volume of voids. In another embodiment, the voids having a volume which is above the volume of the component*10⁻⁴ are not considered to calculate the volume of voids. In another embodiment, the voids having a volume which is above the volume of the component*10⁻⁵ are not considered to calculate the volume of voids. In another embodiment, the voids having a volume which is above the volume of the component*10⁶ are not considered to calculate the volume of voids. Throughout the present document, the volume of NMVS, and the volume of NMVT is measured according to Pure & Appl. Chern., Vol. 66. No, 8, pp. 1739-1758, 1994.

For certain applications, the presence of certain % NMVS (as previously defined) in the metallic part of the component after applying the forming step can be advantageous. The inventor has found that for some applications, the presence of certain % NMVS in the metallic part of the component after applying the forming step is advantageous, particularly when the levels of oxygen and/or nitrogen in the component are controlled. In an embodiment, the % NMVS in the metallic part of the component after applying the forming step is the proper level of % NMVS. Unless otherwise stated, the feature “proper level of % NMVS” is defined throughout the present method in the form of different alternatives, that are explained in detail below. In different embodiments, the proper level of % NMVS is above 0.02%, above 0.2%, above 1.1%, above 6% and even above 12%. For certain applications, higher values are preferred. In different embodiments, the proper level of % NMVS is above 21%, above 31%, above 51%, above 76% and even above 86%. In these applications, the % NMVS in the metallic part of the component after applying the forming step should be controlled to avoid excessively high levels. In different embodiments, the proper level of % NMVS is below 99.98%, below 99.8%, below 98%, below 74%, below 49% and even below 39%. For certain applications, lower values are preferred. In different embodiments, the proper level of % NMVS is below 29%, below 24%, below 14%, below 9% and even below 4%. For some applications, lower values are preferred and even their absence (% NMVS=0). The inventor has found that for some applications, there is a certain relation between the % NMVS in the metallic part of the component after applying the forming step and the AM process temperature (as previously defined) employed in the forming step. In different embodiments, when the AM process temperature (as previously defined) employed in the forming step is below the reference temperature (as previously defined), the % NMVS in the metallic part of the component after applying the forming step is above 0.02%, above 6%, above 31%, above 51%, above 76% and even above 86%. For some applications, it is advantageous to keep the % NMVS in the metallic part of the component below a certain value. In different embodiments, when the AM process temperature (as previously defined) employed in the forming step is below the reference temperature (as previously defined), the % NMVS in the metallic part of the component after applying the forming step is below 99.98%, below 99.8%, below 98%, below 74%, below 49% and even below 24%. The above disclosed about the % NMVS in the metallic part of the component when the AM process temperature (as previously defined) employed the forming step is below the reference temperature (as previously defined) may also be applied to the AM methods comprising the use of an organic material. As previously disclosed, for some applications, an AM process temperature (as previously defined) equal to or above the reference temperature (as previously defined) is preferred. In different embodiments, when the AM process temperature (as previously defined) employed in the forming step is equal to or above the reference temperature (as previously defined), the % NMVS in the metallic part of the component after applying the forming step is below 99.8%, below 29%, below 24%, below 9%, below 4% and even 0%. For some applications, it is advantageous to keep the % NMVS in the metallic part of the component above a certain value. In different embodiments, when the AM process temperature (as previously defined) employed in the forming step is equal to or above the reference temperature (as previously defined), the % NMVS in the metallic part of the component after applying the forming step is above 0.02%, above 0.2%, above 1.1%, above 6% and even above 12%. All the embodiments disclosed above can be combined among them in any combination, provided that they are not mutually exclusive, for example: in an embodiment, the % NMVS in the metallic part of the component after applying the forming step is above 6% and below 98%; or for example: in another embodiment, the maximum temperature employed in the AM method is equal to or above 0.36*Tm, being Tm the melting temperature of the metallic powder with the lowest melting point in the powder mixture, and the % NMVS in the metallic part of the component after applying the forming step is above 0.02% and below 99.8%; or for example: in another embodiment, the mean shaping temperature employed in the AM method is below 0.64*Tm, being Tm the melting temperature of the metallic powder with the lowest melting point in the powder mixture, and the % NMVS in the metallic part of the component after applying the forming step is above 6% and below 99.98%.

The inventor has found that for some applications, what is more relevant is the relation between the volume of NMVS (the volume of voids located inside the metallic part of the component with direct access to the surface of the component without crossing a metal part, as previously defined) and the total volume of the component. In this regard, for some applications, certain levels of % NMVC in the metallic part of the component after applying the forming step are advantageous, being defined the % NMVC (volume of NMVS/total volume of the component)*100. In this context, the volumes are in m³. In an embodiment, the % NMVC in the metallic part of the component after applying the forming step is the proper level of % NMVC. Unless otherwise stated, the feature “proper level of % NMVC” is defined throughout the present method in the form of different alternatives, that are explained in detail below. In different embodiments, the proper level of % NMVC is above 0.3%, above 1.2%, above 3.2%, above 6.2%, above 12% and even above 22%. For some applications, the % NMVC in the metallic part of the component after applying the forming step should be controlled to avoid excessively high levels. In different embodiments, the proper level of % NMVC is below 64%, below 49%, below 24%, below 18%, below 9% and even below 4%. All the embodiments disclosed above can be combined among them in any combination, provided that they are not mutually exclusive, for example: in an embodiment, the % NMVC in the metallic part of the component after applying the forming step is above 0.3% and below 64%.

The inventor has found that for some applications, it is advantageous to apply a machining step to the additively manufactured component obtained after applying the forming step. In an embodiment, the method further comprises the step of: applying a machining to the component obtained after applying the forming step.

As previously disclosed, some of the AM methods which can be employed to form the component in the forming step comprise the use of an organic material such as, but not limited to, a polymer and/or a binder. In some of these embodiments, the additively manufactured component obtained after applying the forming step can be subjected to a debinding step to eliminate at least part of the organic material. In an embodiment, the method further comprises the step of: applying a debinding. The step of: applying a debinding is also referred throughout the present method as the debinding step. In an embodiment, the method comprises the following steps:
providing a powder or powder mixture;
applying an additive manufacturing method to form the component;
applying a debinding;
applying a consolidation treatment; and
optionally, applying a high temperature, high pressure treatment.

For some applications, the atmosphere used in the furnace or pressure vessel where the debinding step is performed may be relevant. Accordingly, in some embodiments, it is important to correctly choose the atmosphere in the debinding step to achieve the desirable performance of the manufactured component. In an embodiment, the debinding step takes place in a properly designed atmosphere (as previously defined). In an embodiment, the debinding step comprises the use of a properly designed atmosphere (as previously defined). For certain applications, it is advantageous to change the atmosphere used during the debinding step (such as, but not limited to, the use of a properly designed atmosphere, as previously defined, only in a part of debinding step and/or the use of at least two different properly designed atmospheres, as previously defined, in the debinding step). In an embodiment, a properly designed atmosphere (as previously defined) is used to perform at least part of the debinding step. Accordingly, any embodiment that relates to a properly designed atmosphere disclosed in this document can be combined with the debinding step in any combination, provided that they are not mutually exclusive. In an embodiment, the debinding step comprises the use of at least two different atmospheres. In another embodiment, the debinding step comprises the use of at least three different atmospheres. In another embodiment, the debinding step comprises the use of at least four different atmospheres. For some applications, it is also advantageous the use of any of the atmospheres disclosed later in the fixing step. For certain applications, it is advantageous to use a right carbon potential of the furnace or pressure vessel atmosphere in relation to the carbon potential of the surface of the component (as defined later) in the debinding step. In an embodiment, the debinding step comprises the use of a right carbon potential of the furnace or pressure vessel atmosphere in relation to the carbon potential of the surface of the component (as defined later). Accordingly, any embodiment that relates to a right carbon potential of the furnace or pressure vessel atmosphere in relation to the carbon potential of the surface of the component disclosed in this document can be combined with the debinding step in any combination, provided that they are not mutually exclusive. For certain applications, it is advantageous to use a right carbon potential of the furnace or pressure vessel atmosphere in relation to the carbon content in the metallic part of the component (as defined later) after applying the debinding step. In an embodiment, the debinding step comprises the use of a right carbon potential of the furnace or pressure vessel atmosphere in relation to the carbon content in the metallic part of the component (as defined later) after applying the debinding step. The carbon potential of the furnace or pressure vessel atmosphere in relation to the carbon content in the metallic part of the component after applying the debinding step is defined as the absolute value of [(carbon content in the metallic part of the component after applying the debinding step—carbon potential of the furnace or pressure vessel atmosphere)/carbon potential of the furnace or pressure vessel atmosphere]*100. Accordingly, any embodiment that relates to a right carbon potential of the furnace or pressure vessel atmosphere in relation to the carbon content in the metallic part of the component disclosed in this document can be combined with the debinding step in any combination, provided that they are not mutually exclusive. For certain applications, the use of a right nitriding atmosphere (as defined later) in the debinding step is advantageous. In an embodiment, the debinding step comprises the use of a right nitriding atmosphere. Accordingly, any embodiment that relates to a right nitriding atmosphere disclosed in this document can be combined with the debinding step in any combination, provided that they are not mutually exclusive. The inventor has found that for some applications, it is particularly advantageous the use of a right nitriding atmosphere comprising the application of a high nitriding temperature in combination with the application of overpressure and/or certain vacuum (as defined later) in the debinding step. For some applications, what is more relevant is the weight percentage of nitrogen at the surface of the component after applying the debinding step. For a given composition of the powder, the skilled in the art knows how to select the temperature, nitriding potential and other relevant variables, so that according to simulation, the weight percentage of nitrogen (% N) at the surface after applying the debinding step is the right nitrogen content (as defined later). In an embodiment, simulation is performed with ThermoCal (version 2020b). In an embodiment, the weight percentage of nitrogen at the surface after applying the debinding step is the right nitrogen content (as defined later). Accordingly, any embodiment that relates to the right nitrogen content disclosed in this document can be combined with the debinding step in any combination, provided that they are not mutually exclusive. For certain applications, the use of an % O₂ comprising atmosphere at the right temperature for the right time (as defined in this document) in the debinding step is advantageous. In an embodiment, the debinding step comprises the use of an % O₂ comprising atmosphere at the right temperature for the right time. Accordingly, any embodiment that relates to an % O₂ comprising atmosphere at the right temperature for the right time disclosed in this document can be combined with the debinding step in any combination, provided that they are not mutually exclusive. In an embodiment, the atmosphere used in the debinding step comprises the application of a high vacuum level (as defined in this document). Accordingly, any embodiment that relates to a high vacuum level disclosed in this document can be combined with the debinding step in any combination, provided that they are not mutually exclusive. For some applications, the use of a properly designed atmosphere (as previously defined) comprising the application of a high vacuum level (as defined later) in the debinding step is preferred.

The debinding method which can be used is not particularly limited as long as the desired amount of organic material is eliminated. Examples of debinding methods that can be employed include, but are not limited to: thermal debinding, non-thermal debinding (such as, but not limited to, catalytic, wicking, drying, supercritical extraction, organic solvent extraction, water-based solvent extraction and/or freeze drying . . . ) chemical debinding and/or combinations thereof. In an embodiment, the debinding step comprises a non-thermal debinding. In an embodiment, the debinding step comprises a chemical debinding. In an embodiment, the debinding step comprises a thermal debinding. For some applications, it is important to correctly choose the temperature applied in the debinding step. In different embodiments, the temperature in the debinding step is 51° C. or more, 110° C. or more, 255° C. or more, 355° C. or more, 455° C. or more and even 610° or more. For some applications, it is particularly important to avoid excessively high temperatures in the debinding step. In different embodiments, the temperature in the debinding step is 1390° C. or less, 890° C. or less, 690° C. or less, 590° C. or less, 490° C. or less and even 190° C. or less.

The inventor has found that for some applications, it is advantageous to apply a machining step to the component obtained after eliminating at least part of the organic material. In an embodiment, the method further comprises the step of: applying a machining to the component obtained after applying the debinding step.

The inventor has found that for some embodiments, the application of a pressure and/or temperature treatment to the component before and/or after applying the debinding may help to improve the mechanical properties of the manufactured component. In an embodiment, the method further comprises the step of: applying a pressure and/or temperature treatment before applying the debinding step. In an embodiment, the method further comprises the step of: applying a pressure and/or temperature treatment after applying the debinding step.

For some applications, it is important which means are used to apply the pressure. On the other hand, some applications are rather insensitive as how pressure is applied and even the pressure level attained. In this regard, the inventor has found that some applications benefit from the application of the pressure in a homogeneous way as previously defined in this document. In an embodiment the pressure and/or temperature treatment comprises applying the “strategies developed for the application of pressure in a homogeneous way”. The inventor has also found that for some applications, it is particularly advantageous to perform at least part of the heating using microwaves as previously defined in this document. In an embodiment, the pressure and/or temperature treatment comprises applying a “microwave heating” (as previously defined).

In some embodiments, the pressure employed in the pressure and/or temperature treatment may be relevant to the mechanical properties of the manufactured component. In different embodiments, the pressure applied in the pressure and/or temperature treatment is 6 MPa or more, 60 MPa or more, 110 MPa or more, 220 MPa or more, 340 MPa or more, 560 MPa or more, 860 MPa or more and even 1060 MPa or more. For some applications, the application of excessive pressure seems to deteriorate the mechanical properties of the manufactured component. In different embodiments, the pressure applied in the pressure and/or temperature treatment is 2100 MPa or less, 1600 MPa or less, 1200 MPa or less, 990 MPa or less, 790 MPa or less, 640 MPa or less, 590 MPa or less and even 390 MPa or less. In an embodiment, the pressure applied in the pressure and/or temperature treatment refers to the mean pressure applied in the pressure and/or temperature treatment. In an alternative embodiment, the pressure applied in the pressure and/or temperature treatment refers to the minimum pressure applied in the pressure and/or temperature treatment. In another alternative embodiment, the pressure applied in the pressure and/or temperature treatment refers to the mean pressure applied in the pressure and/or temperature treatment, wherein the mean pressure is calculated excluding any pressure which is applied for less than a critical time (as previously defined). For some applications, the maximum pressure applied in the pressure and/or temperature treatment may be relevant. In different embodiments, the maximum pressure in the pressure and/or temperature treatment is 105 MPa or more, 210 MPa or more, 310 MPa or more, 405 MPa or more, 640 MPa or more, 1260 MPa or more and even 2600 MPa or more. In different embodiments, the maximum pressure applied in the pressure and/or temperature treatment is 2100 MPa or less, 1200 MPa or less, 990 MPa or less, 790 MPa or less, 640 MPa or less, than 590 MPa or less, 490 MPa or less and even 390 MPa or less. In an embodiment, any pressure which is maintained less than a “critical time” (as previously defined) is not considered a maximum pressure. In an embodiment, the maximum pressure is applied for a “relevant time” (as previously defined). In an embodiment, the pressure is applied in a continuous way. In an embodiment, the pressure is applied in a continuous way for a “relevant time” (as previously defined). In an embodiment, at least part of the pressure of the fluid is applied directly over the mold. In an embodiment, the pressure of the fluid is applied directly over the mold. In an embodiment, when the component comprises internal features, at least part of the pressure of the fluid is applied directly over the internal features. In an embodiment, when the component comprises internal features, the pressure of the fluid is applied directly over the internal features. In an embodiment, when the component comprises internal features, the pressure of the particle fluidized bed is applied directly over the internal features.

For some applications, the temperature applied in the pressure and/or temperature treatment may be relevant to the mechanical properties of the manufactured component. The inventor has found that for some applications, a certain relation between the melting temperature of the powder or powder mixture used to manufacture the component and the temperature involved in the pressure and/or temperature treatment may be advantageous. In different embodiments, the temperature applied in the pressure and/or temperature treatment is below 0.94*Tm, below 0.84*Tm, below 0.74*Tm, below 0.64*Tm, below 0.44*Tm, below 0.34*Tm, below 0.29*Tm and even below 0.24*Tm, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In another alternative embodiment, Tm refers to the melting temperature of a powder mixture (as previously defined). For some applications, when only one powder is used, Tm is the melting temperature of the powder. In this context, the temperatures disclosed above are in kelvin. For some applications, the temperature should be maintained above a certain value. In different embodiments, the temperature applied in the pressure and/or temperature treatment is above 0.16*Tm, above 0.19*Tm, above 0.26*Tm, above 0.3*Tm, above 0.45*Tm, above 0.61*Tm, above 0.69*Tm, above 0.74*Tm and even above 0.86*Tm, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In other alternative embodiments, Tm refers to the melting temperature of a powder mixture (as previously defined). For some applications, when only one metallic powder is used, Tm is the melting temperature of the metallic powder. In this context, the temperatures disclosed above are in kelvin. For some applications, it is better to define the temperature applied in the pressure and/or temperature treatment in absolute terms. In different embodiments, the temperature applied in the pressure and/or temperature treatment is below 649° C., below 440° C., below 298° C., below 249° C., below 149° C., below 90° C., below 49° C. and even below 29° C. For some applications, the temperature applied should be maintained above a certain value. In different embodiments, the temperature applied in the pressure and/or temperature treatment is above −14° C., above 9° C., above 31° C., above 46° C., above 86° C., above 110° C., above 156° C., above 210° C., above 270° C. and even above 310° C. In an embodiment, the temperature applied in the pressure and/or temperature treatment refers to the maximum temperature applied in the pressure and/or temperature treatment. In an alternative embodiment, the temperature applied in the pressure and/or temperature treatment refers to the mean temperature applied in the pressure and/or temperature treatment. In an embodiment, the mean temperature is calculated excluding any temperature which is maintained for less than a “critical time” (as previously defined). For some applications, the maximum temperature applied in the pressure and/or temperature treatment may be relevant to the mechanical properties of the manufactured component. In different embodiments, the maximum temperature applied in the pressure and/or temperature treatment is less than 995° C., less than 495° C., less than 245° C., less than 145° C. and even less than 85° C. For some applications, the maximum temperature applied should be above a certain value. In different embodiments, the maximum temperature applied in the pressure and/or temperature treatment is at least 26° C., at least 46° C. at least 76° C., at least 106° C., at least 260° C., at least 460° C., at least 600° C. and even at least 860° C. In an embodiment, the maximum temperature is maintained for a “relevant time” (as previously defined). In an embodiment, any temperature which is maintained for less than a “critical time” (as previously defined) is not considered a maximum temperature. For some applications, the minimum temperature applied may be relevant. In different embodiments, the minimum temperature applied in the pressure and/or temperature treatment is −29° C., −2° C., 9° C., 16° C., 26° C. and even 76° C. For some applications, the minimum temperature applied should be below a certain value. In different embodiments, the minimum temperature applied in the pressure and/or temperature treatment is less than 99° C., less than 49° C., less than 19° C., less than 1° C., less than −6° C. and even less than −26° C. For some applications, the minimum temperature applied should be above a certain value. In different embodiments, the minimum temperature in the pressure and/or temperature treatment is at least −51° C., at least −16° C., at least 0.1° C., at least 11° C., at least 26° C., at least 51° C. and even at least 91° C. In an embodiment, the minimum temperature is maintained for a “relevant time” (as previously defined). In an embodiment, any temperature which is maintained less than a “critical time” (as previously defined) is not considered a minimum temperature. In an embodiment, the temperature in the pressure and/or temperature treatment refers to the temperature of the pressurized fluid used to apply the pressure in the pressure and/or temperature treatment. The inventor has found that for some applications, significant variations in the temperature of the pressurized fluid during the pressure and/or temperature treatment are advantageous. In different embodiments, the maximum temperature gradient of the pressurized fluid during the pressure and/or temperature treatment is more than 6° C., more than 11° C., more than 16° C., more than 21° C., more than 55° C., more than 105° C. and even more than 145° C. For some applications, the maximum temperature gradient should be limited below a certain value. In different embodiments, the maximum temperature gradient of the pressurized fluid during the pressure and/or temperature treatment is less than 380° C., less than 290° C., less than 245° C., less than 149° C., less than 94° C., less than 49° C., less than 24.4° C., less than 23° C. and even less than 19° C. For some applications, the maximum temperature gradient should be maintained for a certain time. In different embodiments, a certain time is at least 1 second, at least 21 second and even at least 51 second. For some applications, excessive maintenance time may be detrimental. In different embodiments, a certain time is less than 4 minutes, less than 1 minute, less than 39 seconds, less than 19 seconds. In an embodiment, the maximum pressure and temperature achieved in the pressure and/or temperature treatment takes place at the same time. All the embodiments disclosed above can be combined among them in any combination, provided that they are not mutually exclusive.

For some applications, a minimum processing time is required. In different embodiments, the pressure and/or temperature treatment processing time is at least 1 min, at least 6 min, at least 25 min, at least 246 min, at least 410 min and even at least 1200 min. For some applications, excessive processing time seems to deteriorate the mechanical properties of the manufactured component. In different embodiments, the pressure and/or temperature treatment processing time is less than 119 hours, less than 47 hours, less than 23.9 hours, less than 12 hours, less than 2 hours, less than 54 minutes, less than 34 minutes, less than 24.9 minutes, less than 21 minutes, less than 14 minutes and even less than 8 minutes.

For some applications, the use of a pressure and/or temperature treatment comprising the steps disclosed below is advantageous. In an embodiment, the pressure and/or temperature treatment comprises the following steps:
step i) subjecting the component to high pressure;
step ii) while keeping a high pressure level, raising the temperature of the component;
step iii) while keeping a high enough temperature, releasing at least some of the to the component applied pressure.

In some particular embodiments, steps ii) and iii) are optional and thus can be avoided. In an embodiment, steps ii) and/or iii) are skipped.

For some applications, step i) is very critical. In an embodiment, subjecting the component to high pressure means subjecting the component to the right amount of maximum pressure. In an embodiment, the right amount of maximum pressure is applied to the component. In an embodiment, the right amount of maximum pressure is applied for a relevant time. In different embodiments, the right amount of maximum pressure is 12 MPa or more, 105 MPa or more, 155 MPa or more, 170 MPa or more, 185 MPa or more, 205 MPa or more, 260 MPa or more and even 302 MPa or more. For some applications, steps ii) and/or iii) can be skipped. In some embodiments, higher pressures are normally required when skipping steps ii) and iii), but also when not skipping them, for some applications it is interesting to use even higher pressures to attain higher apparent density. In different embodiments, the right amount of maximum pressure is 410 MPa or more, 510 MPa or more, 601 MPa or more, 655 MPa or more and even 820 MPa or more. Surprisingly enough, for some applications an excessive amount of pressure in step i) leads to internal defects, even more so for complex and large geometries. In different embodiments, the right amount of maximum pressure is 1900 MPa or less, 900 MPa or less, 690 MPa or less, 490 MPa or less, 390 MPa or less and even 290 MPa or less. In an embodiment, step i) comprises the application of pressure in a stepwise manner (as previously defined). In an embodiment, step i) comprises the application of pressure at a low enough rate (as previously defined). For some applications, it might be interesting to introduce the component in the pressure application device, when the fluid used to apply the pressure is hot. In an embodiment, the pressure application device is any device capable to raising the applied pressure to the right amount of maximum pressure with the appropriate rate and capable of attaining the desired temperature in step ii). In an embodiment, the pressure application device is any device capable to raising the applied pressure to the right amount of maximum pressure. In different embodiments, the fluid being hot means it has a temperature of 35° C. or more, 45° C. or more, 55° C. or more, 75° C. or more, 105° C. or more, 155° C. or more.

For some applications, step ii) is very important and the values of the relevant parameters have to be controlled properly. In an embodiment, the temperature of the component (as previously defined) is raised while keeping the right pressure level in step ii). In an embodiment, the temperature of the component (as previously defined) is raised by heating up the fluid that exerts the pressure. In an embodiment, the temperature is raised at least through radiation. In an embodiment, the temperature is raised at least through convection. In an embodiment, the temperature is raised at least through conduction. In different embodiments, the temperature of the component in step ii) is raised to 320 K or more, 350 K or more, 380 K or more, 400 K or more, 430 K or more and even 480 K or more. For some applications it is important to assure the temperature of the component is not excessive in step ii). In an embodiment, the temperature of the component (as previously defined) is kept below 690 K, below 660 K, below 560 K, below 510 K, below 470 K and even below 420 K. For some applications, what is more relevant is the maximum relevant temperature achieved in step ii). In an embodiment, the maximum relevant temperature (as previously defined) achieved in step ii) is 190° C. or less, 140° C. or less, 120° C. or less, 90° C. or less, Tm+50° C. or less, Tm+30° C. or less, Tm+10° C. or less, Tm or less and even Tm·20° C. or less. In an embodiment, Tm is the molting temperature of the powder or powder mixture used to form the component. In some embodiments the maximum relevant temperature applied in step ii) is the maximum temperature applied in step ii). As previously disclosed, the temperature of the component is raised while keeping the right pressure level in step ii). In an embodiment, the right pressure level refers to the minimum pressure applied to the component in step ii). In another embodiment, the right pressure level refers to the maximum pressure applied to the component in step ii). In another embodiment, the right pressure level refers to any pressure applied to the component in step ii). In another embodiment, the right pressure level refers to the mean pressure (time weighted) applied to the component in step ii). In different embodiments, the right pressure level in step ii) is 0.5 MPa or more, 5.5 MPa or more, 10.5 MPa or more, 21 MPa or more, 105 MPa or more, 160 MPa or more and even 215 MPa or more. For some applications, it has been found that an excessive pressure in this step leads to undesirable distortions. In different embodiments, the right pressure level in step ii) is 1300 MPa or less, 860 MPa or less, 790 MPa or less, 490 MPa or less, 390 MPa or less, 290 MPa or less, 190 MPa or less, 90 MPa or less and even 39 MPa or less.

For some applications, step iii) is very important to avoid internal defects in the manufactured components. In an embodiment, while keeping a high enough temperature, at least some of the to the component applied pressure is released in step iii). In an embodiment, the temperature of the component is as previously defined. In different embodiments, a high enough temperature in step iii) means 320 K or more, 350 K or more, 380 K or more, 400 K or more, 500 K or more. For some applications it is important to assure the temperature of the component is not excessive. In different embodiments, the temperature of the component in method step iii) is kept below 690 K, below 660 K, below 560 K, below 510 K, below 470 K and even below 420 K. For some applications, what is more relevant is the maximum relevant temperature achieved in step iii). In an embodiment, the maximum relevant temperature (as previously defined) achieved in step ii) is 190° C. or less, is 140° C. or less, 120° C. or less, 90° C. or less, Tm+50° C. or less, Tm+30° C. or less, Tm+10° C. or less, Tm or less and even Tm−20° C. or less. In an embodiment, Tm is the melting temperature of the powder or powder mixture used to form the component. In some embodiments the maximum relevant temperature applied in step iii) is the maximum temperature applied in step iii). In an embodiment, step iii) comprises releasing at least some of the to the component applied pressure in step iii) as previously defined. In an embodiment, the percentage lowering of the pressure refers not only to step i), but to any of steps i), ii) or iii) and thus the highest pressure achieved in any of them. In different embodiments, the pressure is lowered at least 0.6 MPa, at least 2 MPa, at least 10 MPa and even at least MPa with respect to the highest value achieved in step i). For some applications, the pressure level achieved in step iii) is more important than the percentage reduction. In an embodiment, step iii) should read: while keeping a high enough temperature releasing at least some of to the component applied pressure as to attain a pressure level below 390 MPa, below 90 MPa, below 19 MPa, below 9 MPa, below 4 MPa, below 0.4 MPa and even below 0.2 MPa. In an embodiment, all pressure is removed within step iii). Some applications are quite sensitive, particularly when it comes to internal defects of components, to the rates employed to release the pressure in step iii). In an embodiment, pressure is released at a low enough rate (as previously defined) at least within the final stretch. In an embodiment, the final stretch relates to the final 2%, the final 8%, the final 12%, the final 18% and even the final 48%. [taking as initial point the highest pressure applied to the component in any of steps i), ii) or iii) and as final point the minimum pressure applied to the component in step iii)]. In an embodiment, the final stretch relates to the final 0.1 MPa, the final 0.4 MPa, the final 0.9 MPa, the final 1.9 MPa and even the final 9 MPa [before reaching the minimum pressure applied to the component in step iii)].

In an embodiment, after step iii) the pressure applied to the component is completely released if it was not already done so in step iii). In an embodiment, after step iii) the pressure applied to the component is completely released with the same caution regarding pressure release rates as described above for step iii). In an embodiment, after step iii) the pressure applied to the component is completely released with the same fashion regarding pressure release steps as described above for step iii). In an embodiment, after step iii) the temperature of the component is let drop to close to ambient values if it was not already done do in step iii). In an embodiment, after step iii) the component is let drop to below 98° C. if it was not already done do in step iii). In another embodiment, after step iii) the temperature of the component is let drop to below 48° C. if it was not already done do in step iii). In another embodiment, after step iii) the temperature of the component is let drop to below 38° C. if it was not already done do in step iii). In an embodiment, after step iii) the temperature of the component is let drop to a value convenient for carrying out the following method step if it was not already done do in step iii).

One should be surprised at the length of the process required for the present invention for steps i) to iii) which is much higher than that involved in other high-pressure moderate temperature (below 0.5*Tm and very often below 0.3*Tm) existing processes. In an embodiment, the total time of steps i) to iii) is higher than 22 minutes, higher than 190 minutes, higher than 410 minutes. For some applications, excessively long times are disadvantageous. In different embodiments, the total time of steps i) to iii) is lower than 47 hours, lower than 12 hours and even lower than 7 hours. Another singular overall characteristic of the process employed in steps i) to iii)) is the large variations in temperature of the pressurized fluid taking place within the process. In different embodiments, the pressurized fluid maximum temperature gradient in steps i) to iii is 25° C. or more, 55° C. or more, 105° C. or more. For some applications, excessively high temperature gradients should be avoided. In different embodiments, the pressurized fluid maximum temperature gradient in steps i) to iii) is 245° C. or less, 195° C. or less and even 145° C. or less.

For certain applications, the use of several cycles is advantageous. In an embodiment, at least two cycles of pressure and/or temperature treatment are applied. In another embodiment, at least three cycles of pressure and/or temperature treatment are applied.

The inventor has found that for some applications, it is advantageous to apply a machining step after applying the pressure and/or temperature treatment. In an embodiment, the method further comprises the step of: applying a machining to the component obtained after applying the pressure and/or temperature treatment.

The inventor has found that for some applications, fixing certain levels of oxygen and/or nitrogen in the metallic part of the component may help to improve the mechanical properties that can be reached in the manufactured component. In an embodiment, the method further comprises the step of: setting the nitrogen and/or oxygen level of the metallic part of the component before applying the consolidation step. The step of: setting the nitrogen and/or oxygen level of the metallic part of the component is also referred throughout the present method as the fixing step. In an embodiment, the method comprises the following steps: —providing a powder or powder mixture; —applying an additive manufacturing method to form the component: —optionally, applying a pressure and/or temperature treatment: —optionally, applying a debinding; —optionally, applying a pressure and/or temperature treatment: -setting the nitrogen and/or oxygen level of the metallic part of the component; —applying a consolidation treatment; and —optionally, applying a high temperature, high pressure treatment.

For some applications, the fixing step and the consolidation step can be performed simultaneously and/or in the same furnace or pressure vessel. In an embodiment, the fixing step and the consolidation step are performed simultaneously. In an embodiment, the fixing step and the consolidation step are performed in the same furnace or pressure vessel.

The inventor has found that for some applications, it is advantageous to apply a debinding step (as previously defined) to eliminate at least part of the organic material before applying the fixing step (even for some applications, the total elimination of the organic material can be advantageous). In an embodiment, the method comprises the following steps: —providing a powder or powder mixture; —applying an additive manufacturing method to form the component; —optionally, applying a pressure and/or temperature treatment; —applying a debinding; —optionally, applying a pressure and/or temperature treatment; -setting the nitrogen and/or oxygen level of the metallic part of the component; —applying a consolidation treatment; and —optionally, applying a high temperature, high pressure treatment.

The inventor has found that for some applications, it is advantageous to perform the debinding step and the fixing step simultaneously and/or in the same furnace or pressure vessel. In an embodiment, the debinding step and the fixing step are performed simultaneously. In an embodiment, the debinding step and the fixing step are performed in the same furnace or pressure vessel. For some applications, it is also advantageous perform the debinding step, the fixing step and the consolidation step simultaneously and/or in the same furnace or pressure vessel. In an embodiment, the debinding step, the fixing step and the consolidation step are performed simultaneously. In an embodiment, the debinding step and the fixing step are performed in the same furnace or pressure vessel. As previously disclosed for certain applications, what is more advantageous is to perform the fixing step and the consolidation step simultaneously and/or in the same furnace or pressure vessel. In an embodiment, the fixing step and the consolidation step are performed simultaneously. In an embodiment, the fixing step and the consolidation step are performed in the same furnace or pressure vessel.

For some applications, the atmosphere used in the furnace or pressure vessel where the fixing step is performed is relevant. The inventor has found that for some applications, it is particularly advantageous to use a properly designed atmosphere (as previously defined) in the fixing step. In an embodiment, the fixing step comprises the use of a properly designed atmosphere. For certain applications, it is advantageous to change the atmosphere used during the fixing step (such as, but not limited to, the use of a properly designed atmosphere only in a part of the fixing step and/or the use of at least two different properly designed atmospheres in the fixing step). In an embodiment, a properly designed atmosphere (as previously defined) is used to perform at least part of the fixing step. Accordingly, any embodiment that relates to a properly designed atmosphere disclosed in this document can be combined with the fixing step in any combination, provided that they are not mutually exclusive. In an embodiment, the fixing step comprises the use of at least two different atmospheres. In another embodiment, the fixing step comprises the use of at least three different atmospheres. In another embodiment, the fixing step comprises the use of at least four different atmospheres. The fixing step in a properly designed atmosphere (as previously defined) is applicable not only within the present method but may also be applied to other powders or powder mixtures with a proper oxygen and/or nitrogen content (as previously defined) which are consolidated to manufacture a component, and thus might constitute an invention on their own. For certain applications, the use of a properly designed atmosphere (as previously defined) comprising the application of a high vacuum level is preferred. In an embodiment, the atmosphere used in the fixing step comprises the application of a high vacuum level. Unless otherwise stated, the feature “high vacuum level” is defined throughout the present document in the form of different alternatives that are explained in detail below. In different embodiments, a high vacuum level means a vacuum level of 0.9*10⁻³ mbar or better, of 0.9*10⁻⁴ mbar or better, of 0.9*10⁻⁵ mbar or better, of 0.9*10⁻⁶ mbar or better and even of 0.9*10⁻⁷ mbar or better. For some applications, an excessively low vacuum level is not helpful. In different embodiments, a high vacuum level means a vacuum level of 0.9*10⁻¹² mbar or worse, of 0.9*10⁻¹¹ mbar or worse, of 0.9*10⁻¹⁰ mbar or worse, of 0.9*10⁻⁹ mbar or worse and even of 0.9*10⁻⁸ mbar or worse. All the embodiments disclosed above can be combined among them and with any other embodiment disclosed in this document that relates to a “high vacuum level” in any combination, provided that they are not mutually exclusive. In an embodiment, the use of a properly designed atmosphere comprising the application of a high vacuum level is particularly advantageous when the powder or powder mixture provided comprises at least a powder with the proper level of % V, % Nb, % Ta and/or % Ti (as previously defined). In an embodiment, the use of a properly designed atmosphere comprising the application of a high vacuum level is particularly advantageous when the powder or powder mixture provided comprises at least a powder with the proper level of % Mn (as previously defined). In an embodiment, the use of a properly designed atmosphere comprising the application of a high vacuum level is particularly advantageous when the powder or powder mixture provided comprises at least a powder with the proper level of % Al and/or % Si (as previously defined). In an embodiment, the use of a properly designed atmosphere comprising the application of a high vacuum level is particularly advantageous when the powder or powder mixture provided comprises at least a powder with the proper level of % Moeq (as previously defined). In an embodiment, the use of a properly designed atmosphere comprising the application of a high vacuum level is particularly advantageous when the powder or powder mixture provided comprises at least a powder with the proper level of % Cr (as previously defined). Other applications may also benefit from the use of a properly designed atmosphere comprising the application of a high vacuum level. In an embodiment, the use of a properly designed atmosphere comprising the application of a high vacuum level is particularly advantageous when the powder or powder mixture provided comprises at least one of the following metal or metal alloys in powdered form: iron or an iron based alloy, a steel, a stainless steel, titanium or a titanium based alloy, aluminium or an aluminium based alloy, magnesium or a magnesium based alloy, nickel or a nickel based alloy, copper or a copper based alloy, niobium or a niobium based alloy, zirconium or a zirconium based alloy, silicon or a silicon based alloy, chromium or a chromium based alloy, cobalt or a cobalt based alloy, molybdenum or a molybdenum based alloy, manganese or a manganese based alloy, tungsten or a tungsten based alloy, lithium or a lithium based alloy, tin or a tin based alloy, tantalum or a tantalum based alloy and/or mixtures thereof. All the embodiments disclosed above can be combined among them in any combination, provided that they are not mutually exclusive, for example: in an embodiment, the powder mixture provided comprises a powder with a % V content which is above &wt % and below 89 wt % and the fixing step is performed in an atmosphere comprising the application of a vacuum between 0.9*10⁻¹² mbar and 0.9*10⁻³ mbar.

For certain applications, it is advantageous to use a right carbon potential of the furnace or pressure vessel atmosphere in relation to the carbon potential of the surface of the component in the fixing step. In an embodiment, the fixing step comprises the use of an atmosphere with a right carbon potential of the furnace or pressure vessel atmosphere in relation to the carbon potential of the surface of the component. The carbon potential of the furnace or pressure vessel atmosphere in relation to the carbon potential of the surface of the component in the fixing step is defined as the absolute value of [(carbon potential of the surface of the component—carbon potential of the furnace or pressure vessel atmosphere)/carbon potential of the furnace or pressure vessel atmosphere]*100. For some applications, this relation is preferred below a certain value. In different embodiments, the right carbon potential of the furnace or pressure vessel atmosphere in relation to the carbon potential of the surface of the component is below 69%, below 49%, below 24%, below 14%, below 4% and even below 0.9%. On the other hand, there are some applications where a certain difference in the right carbon potential of the furnace or pressure vessel atmosphere in relation to the carbon potential of the surface of the component is preferred. In different embodiments, the right carbon potential of the furnace or pressure vessel atmosphere in relation to the carbon potential of the surface of the component is above 0.0001%, above 0.002%, above 0.01%, above 2% and even above 11%. For some applications, an atmosphere with a right carbon potential of the furnace or pressure vessel atmosphere in relation to the carbon potential of the surface of the component as defined in any of the embodiments above can be advantageously applied in other methods or method steps disclosed throughout this document, and particularly in any one of the debinding, the fixing, the consolidation and/or the densification steps described throughout the present document. Accordingly, all the embodiments disclosed above can be combined among them and with any other embodiment disclosed in this document that relates to “an atmosphere with a right carbon potential of the furnace or pressure vessel atmosphere in relation to the carbon potential of the surface of the component” in any combination, provided that they are not mutually exclusive. For certain applications, it is advantageous to use a right carbon potential of the furnace or pressure vessel atmosphere in relation to the carbon content in the metallic part of the component after applying the fixing step. In an embodiment, the fixing step comprises the use of an atmosphere with a right carbon potential of the furnace or pressure vessel atmosphere in relation to the carbon content in the metallic part of the component after applying the fixing step. The carbon potential of the furnace or pressure vessel atmosphere in relation to the carbon content in the metallic part of the component after applying the fixing step is defined as the absolute value of [(carbon content in the metallic part of the component after applying the fixing step—carbon potential of the furnace or pressure vessel atmosphere)/carbon potential of the furnace or pressure vessel atmosphere]*100. For some applications, the metallic part of the component may have different zones with different contents of carbon. In an embodiment, the carbon content in the metallic part of the component refers to the carbon content in the zone of the metallic part of the component with the lowest carbon content. In an alternative embodiment, the carbon content in the metallic part of the component refers to the carbon content in the zone of the metallic part of the component with the highest carbon content. In another alternative embodiment, the carbon content in the metallic part of the component refers to the weighted arithmetic mean carbon content (mass-weighted arithmetic mean, where the weights are the weight fractions) in the metallic part of the component. In another alternative embodiment, the carbon content in the metallic part of the component refers to the carbon content of at least one of the zones of the metallic part of the component with different carbon content. In another alternative embodiment, the carbon content in the metallic part of the component refers to the carbon content of more than one of the zones of the metallic part of the component with different carbon content. In different embodiments, the right carbon potential of the furnace or pressure vessel atmosphere in relation to the carbon content in the metallic part of the component is below 69%, below 49%, below 24%, below 14%, below 4% and even below 0.9%. On the other hand, there are some applications where a certain difference in the right carbon potential of the furnace or pressure vessel atmosphere in relation to the carbon content in the composition of the component is preferred. In different embodiments, the right carbon potential of the furnace or pressure vessel atmosphere in relation to carbon content in the composition of the component is above 0.0001%, above 0.002%, above 0.01%, above 2% and even above 11%. In an embodiment, the right carbon potential is the result of measuring the carbon potential in the atmosphere of the furnace or pressure vessel. In an alternative embodiment, the right carbon potential is the result of measuring the carbon potential in the atmosphere of the furnace or pressure vessel by means of oxygen and carbon probes and calculation of the carbon potential. In another alternative embodiment, the right carbon potential is the result of measuring the carbon potential in the atmosphere of the furnace or pressure vessel by means of NDIR (Non-Dispersive Infrared analyzer). In another alternative embodiment, the right carbon potential is determined by simulation using ThermoCalc (version 2020b). In an embodiment, both the right carbon potential of the furnace or pressure vessel atmosphere and that of the component surface are determined by simulation using ThermoCalc (version 2020b). In an alternative embodiment, both the right carbon potential of the furnace or pressure vessel atmosphere and that of the component surface are determined by simulation in the same fashion as done by Torsten Holm and John Agren in chapter II. 15 (The carbon potential during the heat treatment of steel) of “The SGTE Casebook (Second edition)” Thermodinamics At Work from Woodhead Publishing. For some applications, an atmosphere with a right carbon potential of the furnace or pressure vessel atmosphere in relation to carbon content in the metallic part of the component as defined in any of the embodiments above can be advantageously applied in other methods or method steps disclosed throughout this document, and particularly in any one of the debinding, the fixing, the consolidation and/or the densification steps described throughout the present document. Accordingly, all the embodiments disclosed above can be combined among them and with any other embodiment disclosed in this document that relates to “an atmosphere with a right carbon potential of the furnace or pressure vessel atmosphere in relation to carbon content in the metallic part of the component” in any combination, provided that they are not mutually exclusive. For certain applications, the use of a nitriding atmosphere in the fixing step is advantageous. Although it is well known that the optimum temperature for nitriding iron based materials with ammonia is between 500° C. and 550° C. in atmospheres with 5.5 to 12% atomic nitrogen (N), the inventor has surprisingly found that for several applications of the present invention in which it is desirable to raise the % N of the processed material (comparing the % N of the metal part of the component right after applying the forming step and that of the manufactured component), considerably advantageous properties can be achieved by applying much higher temperatures and employing atmospheres with much lower atomic nitrogen contents. In an embodiment, the fixing step comprises the use of a right nitriding atmosphere. Unless otherwise stated, the feature “right nitriding atmosphere” is defined throughout the present document in the form of different alternatives, that are explained in detail below. In an embodiment, a right nitriding atmosphere means an atmosphere comprising the right atomic nitrogen content. In some embodiments, the right atomic nitrogen content means a certain molar percentage (mol %). In different embodiments, the right atomic nitrogen content is 0.078 mol % or more, 0.78 mol % or more, 1.17 mol % or more, 1.56 mol % or more, 2.34 mol % or more, 3.55 mol % or more and even 4.68 mol % or more. For certain applications, an excessive content is detrimental. In different embodiments, the right atomic nitrogen content is 46.8 mol % or less, 15.21 mol % or less, 11.31 mol % or less, 7.91 mol % or less, 5.46 mol % or less and even 3.47 mol % or less. For certain applications, the use of atmospheres comprising higher atomic nitrogen contents is preferred. In different embodiments, the right atomic nitrogen content is 2.14 mol % or more, 4.29 mol % or more, 6.24 mol % or more, 8.19 mol % or more, 10.14 mol % or more, 21.45 mol % or more and even 39.78 mol % or more. For certain applications, an excessive content is detrimental. In different embodiments, the right atomic nitrogen content is 89 mol % or less, 69 mol % or less, 49 mol % or less, 29 mol % or less, 19 mol % or less, 14 mol % or less and even 9 mol % or less. For some applications, the atomic nitrogen content can be replaced by any alternative atmosphere providing the same percentual amount of atomic nitrogen. For some applications, atomic nitrogen is introduced by using ammonia (NH₃). In an embodiment, a right nitriding atmosphere means an atmosphere comprising the right nitrogen content. In different embodiments, an atmosphere with the right nitrogen content is an atmosphere with a nitrogen content which is 0.02 wt % or more, 0.2 wt % or more, 0.3 wt % or more, 0.4 wt % or more, 0.6 wt % or more, 0.91 wt % or more and even 1.2 wt % or more. For certain applications, an excessive content of nitrogen is detrimental. In different embodiments, an atmosphere with the right nitrogen content is an atmosphere with a nitrogen content which is 3.9 wt % or less, 2.9 wt % or less, 1.9 wt % or less, 1.4 wt % or less and even 0.89 wt % or less. For certain applications, nitriding is performed by exposition to an ammonia based gas mixture. In an embodiment, a right nitriding atmosphere means an atmosphere comprising ammonia. In different embodiments, the ammonia content is above 0.1 vol %, above 0.11 vol %, above 2.2 vol %, above 5.2 vol % and even above 10.2 vol %. For some applications, an excessive content of ammonia is detrimental. In different embodiments, the ammonia content is below 89 vol %, below 49%, below 19 vol % below 14 vol %, below 9 vol % and even below 4 vol %. For some applications, what is more relevant is the weight percentage of nitrogen at the surface of the component after applying the fixing step. For a given composition of the powder, the skilled in the art knows how to select the temperature, nitriding potential and other relevant variables, so that according to simulation, the weight percentage of nitrogen (% N) at the surface after applying the fixing step is the right nitrogen content. In an embodiment, simulation is performed with ThermoCal (version 2020b). In an embodiment, the weight percentage of nitrogen at the surface after applying the fixing step is the right nitrogen content. In different embodiments, the right nitrogen content is 0.02% or more, 0.2% or more, 0.3% or more, 0.4% or more, 0.6% or more, 0.91% or more and even 1.2% or more. For certain applications, an excessive content of nitrogen is detrimental. In different embodiments, the right nitrogen content is 3.9% or less, 2.9% or less, 1.9% or less, 1.4% or less and even 0.89% or less. For some applications, the inventor has found that a rather complex method is useful to attain very exceptional mechanical properties. This is especially the case for alloys where fine oxide particles have been admixed or mechanically alloyed. Besides some other steps described in the present invention, in this case the fixing step is made taking good care to preserve the % NMVS and/or the % NMVC (the proper level of % NMVS and/or % NMVC as previously defined). In some embodiments, the properly designed atmosphere is changed to an atmosphere with the right nitriding potential. Here it has been surprisingly found that it is advantageous to keep the temperature at a much higher level than expected. Accordingly, for certain applications, the use of an atmosphere with the right nitriding potential (Kn) in the fixing step is advantageous. In an embodiment, a right nitriding atmosphere means an atmosphere with the right nitriding potential. The nitriding potential, Kn, is calculated as pNH₃/pH₂^{3/2}, being pNH₃ the partial pressure of NH₃ and pH₂ the partial pressure of H₂. In this context, the partial pressures disclosed above are in bar. In different embodiments, the right nitriding potential means a Kn above 0.002 bar^{-½}, above 0.012 bar^{-½}, above 0.35 bar^{-½}, above 0.2 bar^{-½}, above 0.6 bar^{-½}, above 2 bar^{-½}, above 4.2 bar^{-½} and even above 10.2 bar^{-½}. For some applications, an excessively high nitriding potential is not helpful. In different embodiments, the right nitriding potential means a Kn below 89 bar^{-½}, below 19 bar^{-½}, below 9 bar^{-½}, below 0.4 bar^{-½}, below 0.098 bar^{-½} and even below 0.049 bar^{-½}. In an embodiment, the nitriding potential is measured according to DIN 17 022-4. In an alternative embodiment, the nitriding potential is measured according to SAE AMS 2759/10 B. As previously disclosed, for certain applications the use of exceptionally high nitriding temperatures is unsurprisingly advantageous. In an embodiment, a right nitriding atmosphere comprises the application of a high nitriding temperature. In an embodiment, a right nitriding atmosphere comprises the application of a right nitriding temperature. In different embodiments, a right nitriding temperature refers to a temperature above 580° C., above 655° C., above 755° C., above 855° C., above 910° C. and even above 955° C. For some applications, the temperature is preferred below a certain value. In different embodiments, a right nitriding temperature refers to a temperature below 1440° C., below 1290° C., below 1190° C., below 1090° C., below 990° C. and even below 790° C. For certain applications, it is particularly advantageous to apply overpressure. In an embodiment, a right nitriding atmosphere comprises the application of overpressure. In different embodiments, the overpressure applied is at least 0.0012 bar, at least 0.012 bar, at least 1.7 bar, at least 10.2 bar, at least 20.6 bar and even at least 62 bar. For some applications, the overpressure applied should be maintained below a certain value. In different embodiments, the overpressure applied is less than 4800 bar, less than 740 bar, less than 84 bar, less than 6.9 bar, less than 1.3 bar and even less than 0.74 bar. In some embodiments, the application of a certain vacuum is preferred. In an embodiment, a right nitriding atmosphere comprises the application of a certain vacuum. In different embodiments, a certain vacuum means 590 mbar or better, 99 mbar or better, 9 mbar or better, 0.9 mbar or better, 0.9*10 mbar or better and even 0.9*10⁻⁵ mbar or better. For some applications, an excessively low vacuum is not helpful. In different embodiments, a certain vacuum means 1.2*10⁻⁷ mbar or worse, 1.2*10⁻⁵ mbar or worse, 1.2*10⁻³ mbar or worse and even 0.12 mbar or worse. For some applications, the use of a right nitriding atmosphere with the right nitrogen content comprising the application of a right nitriding temperature in combination with the application of overpressure and/or a certain vacuum is advantageous. In some embodiments, the use of a right nitriding atmosphere with the right atomic nitrogen content comprising the application of a right nitriding temperature is particularly advantageous when the powder or powder mixture comprises a nitrogen austenitic steel powder (as previously defined) or a powder mixture with the mean composition of a nitrogen austenitic steel (as previously defined). In some embodiments, the use of a right nitriding atmosphere with the right atomic nitrogen content comprising the application of a right nitriding temperature is particularly advantageous when the manufactured component has the composition of a nitrogen austenitic steel (as previously defined). In some embodiments, the use of a right nitriding atmosphere with the right atomic nitrogen content comprising the application of a right nitriding temperature is particularly advantageous when the powder or powder mixture provided comprises the right level of % Yeq(1) previously defined in this document. In some embodiments, the use of a right nitriding atmosphere with the right atomic nitrogen content comprising the application of a right nitriding temperature is particularly advantageous when the manufactured component comprises the right level of % Yeq(1) previously defined in this document. In some embodiments, the use of a right nitriding atmosphere with the right atomic nitrogen content comprising the application of a right nitriding temperature is particularly advantageous at least one of the materials comprised in the manufactured component has the right level of % Yeq(1) previously defined in this document. In some embodiments, the use of a right nitriding atmosphere with the right atomic nitrogen content comprising the application of a right nitriding temperature is particularly advantageous when the powder or powder mixture comprises the right content of % Y+% Sc+% REE, % Al+% Y+% Sc+% REE, % Ti+% Y+% Sc+% REE and/or % Al+% Ti+% Y+% Sc+% REE (as previously defined). In some embodiments, the use of a right nitriding atmosphere with the right atomic nitrogen content comprising the application of a right nitriding temperature is particularly advantageous when the manufactured component comprises the right content of % Y+% Sc+% REE, % Al+% Y+% Sc+% REE, % Ti+% Y+% Sc+% REE and/or % Al+% Ti+% Y+% Sc+% REE (as previously defined). On the other hand, in some instances it is advantageous to employ lower temperatures and higher atomic nitrogen contents as customary. For some applications, this is particularly the case when the powder or powder mixture provided comprises a steel powder with a right level of % V+% Al+% Cr+% Mo+% Ta+% W+% Nb (as previously defined). In an embodiment, a right nitriding atmosphere comprises the application of a low nitriding temperature. In an embodiment, a right nitriding atmosphere comprises the application of a right nitriding temperature. In different embodiments, a right nitriding temperature refers to a temperature which is above 220° C., above 310° C., above 460° C., above 510° C., above 610° C. and even above 760° C. For some applications, the temperature is preferred below a certain value. In different embodiments, a right nitriding temperature refers to a temperature which is below 980° C., below 790° C., below 640° C., below 590° C., below 540° C., below 490° C. and even below 390° C. In some embodiments, the use of a right nitriding atmosphere comprising the application of a right nitriding temperature is particularly advantageous when the powder or powder mixture provided comprises a steel powder with a right level of % V+% Al+% Cr+% Mo+% Ta+% W+% Nb (as previously defined). In some embodiments, the use of a right nitriding atmosphere comprising the application of a right nitriding temperature is particularly advantageous when the metallic part of the component comprises a right level of % V+% Al+% Cr+% Mo+% Ta+% W+% Nb (as previously defined) at the time the nitriding atmosphere is removed. In some embodiments, the use of a right nitriding atmosphere comprising the application of a low nitriding temperature is particularly advantageous when the manufactured component comprises a right level of % V+% Al+% Cr+% Mo+% Ta+% W+% Nb (as previously defined). In some embodiments, the above disclosed also applies when the debinding step, the consolidation step and/or the densification step comprise the use of a right nitriding atmosphere. For some applications, a right nitriding atmosphere as defined in any of the embodiments above can be advantageously applied in other methods or method steps disclosed throughout this document, and particularly to each and any one of the debinding, the fixing, the consolidation and/or the densification steps described throughout the present document. Accordingly, all the embodiments disclosed above can be combined among them and with any other embodiment disclosed in this document that relates to “a right nitriding atmosphere” in any combination, provided that they are not mutually exclusive. For some applications, the use of an % O₂ comprising atmosphere in the fixing step is advantageous. In some embodiments, the % O content of at least part of the powder or powder mixture provided may be increased by means of selecting an % O₂ comprising atmosphere at the right temperature for the right time. In an embodiment, the fixing step comprises the use of an % O₂ comprising atmosphere at the right temperature for the right time. Unless otherwise stated, the feature “% O₂ comprising atmosphere at the right temperature for the right time” is defined throughout the present document in the form of different alternatives, that are explained in detail below. For certain applications, the Oz content in the % O₂ comprising atmosphere is relevant. In different embodiments, % O₂ is 0.002 vol % or more, 0.02 vol % or more, 0.11 vol % or more, 0.22 vol % or more, 1.2 vol % or more, 6 vol % or more, 12 vol % or more and even 42 vol % or more. In some particular embodiments, the use of pure Oz may be advantageous. On the contrary, for some applications, the % O₂ should be maintained below a certain level. In different embodiments, the % O₂ is 89 vol % or less, 49 vol % or less, 19 vol % or less, 4 vol % or less and even 0.9 vol % or less. The inventor has also found that for some applications, the presence of Ar, N₂ or other inert gases is advantageous. In an embodiment, the % O₂ comprising atmosphere further comprises a gas which is mainly Ar. In an embodiment, the % O₂ comprising atmosphere further comprises a gas which is mainly an inert gas. In another embodiment, the % O₂ comprising atmosphere further comprises a gas which is mainly N₂. In another embodiment, the % O₂ comprising atmosphere further comprises a gas which is mainly a mixture of inert gases. In different embodiments, the right temperature is a temperature higher than 55° C., higher than 105° C., higher than 155, higher than 176° C., higher than 210° C. and even higher than 260° C. For some applications, excessive temperature may be detrimental. In different embodiments, the right temperature is a temperature lower than 890° C., lower than 590° C., lower than 490° C., lower than 390° C., lower than 345° C., lower than 290° C. and even lower than 240° C. In different embodiments, the right time is more than 1 h, more than 2.5 h, more than 6 h, more than 8 h and even more than 11 h. For some applications, excessively long times are disadvantageous. In different embodiments, the right time is less than 90 h, less than 49 h, less than 29 h, less than 19 h, less than 14 h and even less than 9 h. In some embodiments the use of an % O₂ comprising atmosphere, as disclosed above, is particularly advantageous when the fixing step is made taking good care to preserve the % NMVS and/or the % NMVC. In some embodiments, the use of an % O₂ comprising atmosphere at the right temperature is advantageous when at least some powders are selected with a high but not extremely high oxygen content (as previously defined). For some applications, it has been found that the fixing of the oxygen level is capital, but even more important the relation of the oxygen content to the content of other elements. In an embodiment, the % O content is chosen to comply with the following formula % O≤KYS*(% Y+1.98*% Sc+2.47*% Ti+0.67*% REE), being % REE as previously defined. In another embodiment, the % O content is chosen to comply with the following formula KYI*(% Y+1.98*% Sc+2.47*% Ti+0.67*% REE)<% O≤KYS*(% Y+1.98*% Sc+2.47*% Ti+0.67*% REE), being % REE as previously defined. In different embodiments, KYI is 3800, 2900, 2700, 2650, 2600, 2400, 2200, 2000 and even 1750. In different embodiments, KYS is 2100, 2350, 2700, 2750, 2800, 3000, 3500, 4000, 4500 and even 8000. In an alternative embodiment, what has been disclosed above in this paragraph is modified to ignore % Ti, so that the % Ti contained in the material is not taken into account for the calculations of acceptable % O. In an embodiment, the % O, % Y, % Sc, % Ti and % REE refers to the content of these elements in the metallic part of the component after applying the fixing step. Alternatively, in some embodiments, the inventor has found that it is particularly advantageous when the % O content in the manufactured component (or at least in one of the materials comprised in the manufactured component) is chosen to comply with the above disclosed formulas. In an alternative embodiment, the % O, % Y, % Sc, % Ti and % REE refers to the content of these elements in the manufactured component. In another alternative embodiment, the % O, % Y, % Sc, % Ti and % REE refers to the content of these elements in at least one of the materials comprised in the manufactured component. In another alternative embodiment, the % O, % Y, % Sc, % Ti and % REE refers to the content of these elements at some point during the application of the method. In some embodiments, the use of an % O₂ comprising atmosphere at the right temperature for the right time is advantageous when the powder or powder mixture provided comprises a nitrogen austenitic steel powder (as previously defined) or a powder mixture with the mean composition of a nitrogen austenitic steel (as previously defined). In some embodiments, the use of an % O₂ comprising atmosphere at the right temperature for the right time is particularly advantageous when the manufactured component has the composition of a nitrogen austenitic steel (as previously defined). In some embodiments, the use of an % O₂ comprising atmosphere at the right temperature for the right time is particularly advantageous when the powder or powder mixture provided comprises the % Yeq(1) levels previously defined. In some embodiments, the use of an % O₂ comprising atmosphere at the right temperature for the right time is particularly advantageous when the manufactured component has the % Yeq(1) levels previously defined. In some embodiments, the use of an % O₂ comprising atmosphere at the right temperature for the right time is particularly advantageous when the powder or powder mixture comprises the right content of % Y+% Sc+% REE, % Al+% Y+% Sc+% REE, % Ti+% Y+% Sc+% REE and/or % Al+% Ti+% Y+% Sc+% REE (as previously defined). In some embodiments, the use of an % O₂ comprising atmosphere at the right temperature for the right time is particularly advantageous when the manufactured component comprises the right content of % Y+% Sc+% REE, % Al+% Y+% Sc+% REE, % Ti+% Y+% Sc+% REE and/or % Al+% Ti+% Y+% Sc+% REE (as previously defined). In some embodiments, the above disclosed also applies when the debinding step, the consolidation step and/or the high temperature, high pressure treatment comprise the use of an % O₂ comprising atmosphere. All the embodiments disclosed above can be combined among them and with any other embodiment disclosed in this document that relates to “an % O₂ comprising atmosphere” in any combination, provided that they are not mutually exclusive.

The inventor has found that for some applications, very high mechanical properties, especially in terms of yield strength combined with elongation can be reached when the mean composition of the metallic part of the component comprises certain levels of % V, % Nb, % Ta, % Ti, % Mn, % Si, % Al, % Mo and/or % Cr (the right levels disclosed below in this paragraph) before applying the fixing step. In some of these applications, this effect is particularly relevant when the fixing step (or at least part of the fixing step) is performed in a properly designed atmosphere (as previously defined). For some applications, the use of a properly designed atmosphere comprising the application of a high vacuum level in the fixing step is advantageous. For some applications, very high mechanical properties, especially in terms of yield strength combined with elongation can be reached when the mean composition of the metallic part of the component comprises the right level of % V before applying the fixing step. In an embodiment, the mean composition of the metallic part of the component comprises the right level of % V before applying the fixing step. In different embodiments, the right level of % V is above 0.06 wt %, above 0.12 wt %, above 0.16 wt %, above 0.22 wt % and even above 0.32 wt %. For certain applications, the content of % V should be maintained below a certain level to achieve the desired effect. In different embodiments, the right level of % V is below 8.4 wt %, below 3.9 wt %, below 2.8 wt %, below 2.4 wt %, below 1.9 wt % and even below 0.9 wt %. For some applications, very high mechanical properties, especially in terms of yield strength combined with elongation can be reached when the mean composition of the metallic part of the component comprises the right level of % Nb, % Ta and/or % Ti before applying the fixing step. In an embodiment, the mean composition of the metallic part of the component comprises the right level of % Nb, % Ta and/or % Ti before applying the fixing step. In different embodiments, the right level of % Nb, % Ta and/or % Ti is above 0.06 wt %, above 0.12 wt %, above 0.16 wt %, above 0.22 wt % and even above 0.32 wt %. For certain applications, the right level of % Nb, % Ta and/or % Ti should be maintained below a certain content to achieve the desired effect. In different embodiments, the right level of % Nb, % Ta and/or % Ti is below 8.4 wt %, below 3.9 wt %, below 2.8 wt %, below 2.4 wt %, below 1.9 wt % and even below 0.9 wt %. For some applications, very high mechanical properties, especially in terms of yield strength combined with elongation can be reached when the mean composition of the metallic part of the component comprises the right level of % Mn before applying the fixing step. In an embodiment, the mean composition of the metallic part of the component comprises the right level of % Mn before applying the fixing step. In different embodiments, the right level of % Mn is above 0.12 wt %, above 0.32 wt %, above 0.52 wt % and even above 1.2 wt %. For certain applications, the right level of % Mn should be maintained below a certain content to achieve the desired effect. In different embodiments, the right level of % Mn is below 3.8 wt %, below 2.8 wt %, 1.8 wt % and even below 0.8 wt %. For some applications, very high mechanical properties, especially in terms of yield strength combined with elongation can be reached when the mean composition of the metallic part of the component comprises the right level of % Al and/or % Si before applying the fixing step. In an embodiment, the mean composition of the metallic part of the component comprises the right level of % Si and/or % Al before applying the fixing step. In different embodiments, the right level of % Si and/or % Al is above 0.003 wt %, above 0.01 wt %, above 0.1 wt %, above 0.9 wt %, above 1.2 wt % and even above 5.1 wt %. For certain applications, the right level of % Si and/or % Al should be maintained below a certain content to achieve the desired effect. In different embodiments, the right level of % Si and/or % Al is below 14 wt %, below 9 wt %, below 4 wt %, below 1.9 wt % and even below 0.8 wt %. For some applications, very high mechanical properties, especially in terms of yield strength combined with elongation can be reached when the mean composition of the metallic part of the component comprises the right level of % Moeq before applying the fixing step. In an embodiment, the mean composition of the metallic part of the component comprises the right level of % Moeq (% Moeq=% Mo+½*% W) before applying the fixing step. In different embodiments, the right level of % Moeq is above 0.6 wt %, above 0.8 wt %, above 1.1 wt %, above 1.6 wt %, above 2.1 wt %, above 3.1 wt %, above 4.1 wt % and even above 5.1 wt %. For certain applications, the right level of % Moeq should be maintained below a certain content to achieve the desired effect. In different embodiments, the right level of % Moeq is below 19 wt %, below 14 wt %, below 9 wt %, below 5.4 wt % and even below 3.9 wt %. For some applications, very high mechanical properties, especially in terms of yield strength combined with elongation can be reached when the mean composition of the metallic part of the component comprises the right level of % Cr before applying the fixing step. In an embodiment, the mean composition of the metallic part of the component comprises the right level of % Cr before applying the fixing step. In different embodiments, the right level of % Cr is above 0.6 wt %, above 1.1 wt %, above 3.1 wt %, above 4.1 wt %, above 11.2 wt % and even above 16.2 wt %. For certain applications, the right level of % Cr should be maintained below a certain content to achieve the desired effect. In different embodiments, the right level of % Cr is below 39 wt %, below 28 wt %, below 24 wt %, below 18 wt % and even below 9 wt %. There are certain particular applications, wherein the right level of % Cr is even below 4 wt %. For some applications, very high mechanical properties especially in terms of yield strength combined with elongation can be reached when the mean composition of the metallic part of the component comprises the right level of % V+% Mn+% Cr+% Moeq before applying the fixing step. In an embodiment, the mean composition of the metallic part of the component comprises the right level of % V+% Mn+% Cr+% Moeq before applying the fixing step. In different embodiments, the right level of % V+% Mn+% Cr+% Moeq is above 0.08 wt %, above 1.6 wt %, above 4.1 wt %, above 6.1 wt %, above 15.2 wt % and even above 5.6 wt %. For certain applications, the right level of % V+% Mn+% Cr+% Moeq should be maintained below a certain content to achieve the desired effect. In different embodiments, the right level of % V+% Mn+% Cr+% Moeq is below 49 wt %, below 34 wt %, below 14 wt %, below 6.4 wt % and even below 0.8 wt %. For some applications, very high mechanical properties especially in terms of yield strength combined with elongation can be reached when the mean composition of the metallic part of the component comprises the right level of % Nb+% Ta+% Ti+% Si+% Al before applying the fixing step. In an embodiment, the mean composition of the metallic part of the component comprises the right level of % Nb+% Ta+% Ti+% Si+% Al before applying the fixing step. In different embodiments, the right level of % Nb+% Ta+% Ti+% Si+% Al is above 0.06 wt %, above 0.16 wt %, above 0.31 wt %, above 1.76 wt % and even above 5.6 wt %. For certain applications, the right level of % Nb+% Ta+% Ti+% Si+% Al should be maintained below a certain content to achieve the desired effect. In different embodiments, the right level of % Nb+% Ta+% Ti+% Si+% Al is below 16 wt %, below 6.4 wt %, below 2.9 wt %, below 1.9 wt %, below 1.4 wt % and even below 0.7 wt %. All the embodiments disclosed above can be combined among them in any combination, provided that they are not mutually exclusive, for example: in an embodiment, the mean composition of the metallic part of the component has a % V content which is above 0.06 wt % and below 8.4 wt % before applying the fixing step.

The inventor has found, that for some applications, it is particularly advantageous to use an adequate temperature in the fixing step. In an embodiment, the fixing step comprises the application of an adequate temperature. In different embodiments, an adequate temperature refers to a temperature which is above 220° C., above 420° C., above 610° C., above 920° C., above 1020° C. and even above 1120° C. For some applications, the adequate temperature should be controlled and maintained below a certain value. In different embodiments, an adequate temperature refers to a temperature which is below 1490° C., below 1440° C., below 1398° C., below 1348° C. and even below 1295° C. All the embodiments disclosed above can be combined among them in any combination, provided that they are not incompatible, for example: in an embodiment, the fixing step comprises the application of a temperature above 220° C. and below 1490° C.

The inventor has surprisingly found that for some applications, fixing the nitrogen content in the metallic part of the component to the right levels has a great impact on the improvement of the mechanical properties which can be achieved in the manufactured component, particularly when the component has a complex geometry and/or is large in size (such as, but not limited to, some of the components manufactured with any of the methods disclosed in this document). It is particularly surprising that for some applications, this effect is reached only when the right level of nitrogen is achieved departing from a powder or powder mixture with a proper nitrogen content (as previously defined). For some applications, a method comprising a fixing step to set the nitrogen level of the metallic part of the component is particularly advantageous in combination with the “proper geometrical design strategies” previously defined in this document. In an embodiment, the metallic part of the component has the right level of nitrogen after applying the fixing step. Unless otherwise stated, the feature “right level of nitrogen is defined throughout the present document in the form of different alternatives, that are explained in detail below. In different embodiments, the right level of nitrogen is more than 0.01 ppm, more than 0.06 ppm, more than 1.2 ppm and even more than 5 ppm. All expressed in wt %. For some applications, excessively high levels should be avoided. In different embodiments, the right level of nitrogen is less than 99 ppm, less than 49 ppm, less than 19 ppm, less than 9 ppm, less than 4 ppm and even less than 0.9 ppm. All expressed in wt %. As disclosed in other parts of this document, for some applications, the presence of very high nitrogen contents in the metallic part of the component is preferred. In different embodiments, the right level of nitrogen is 0.02 wt % or more, 0.2 wt % or more, 0.3 wt % or more, 0.4 wt % or more, 0.6 wt % or more, 0.91 wt % or more and even 1.2 wt % or more. For certain applications, excessively high levels are detrimental. In different embodiments, the right level of nitrogen is 3.9 wt % or less, 2.9 wt % or less, 1.9 wt % or less, 1.4 wt % or less and even 0.89 wt % or less. In an embodiment, the right level of nitrogen, refers to the right level of nitrogen in the metallic part of the component. All the embodiments disclosed above can be combined among them in any combination, provided that they are not mutually exclusive, for example: in an embodiment, the nitrogen level of the metallic part of the component is set to more than 0.01 ppm and less than 99 ppm: or for example: in another embodiment, the nitrogen level of the metallic part of the component is set between 0.02 wt % and 3.9 wt %. Related to the oxygen content, the inventor has surprisingly found that a good compromise in the mechanical properties of the manufactured component can be reached when the oxygen content in the metallic part of the component is fixed to the right levels in particular a high wear resistance combined with very high mechanical properties, especially in terms of toughness and yield strength can be obtained. It is particularly surprising that for some applications, this effect is reached only when the right level of oxygen is achieved departing from a powder or powder mixture with a proper oxygen content (as previously defined). For some applications, the oxygen level of the metallic part of the component may have an effect over the thermal conductivity which can be reached in the manufactured component. In an embodiment, the metallic part of the component has the right level of oxygen after applying the fixing step. Unless otherwise stated, the feature *right level of oxygen is defined throughout the present document in the form of different alternatives, that are explained in detail below. In different embodiments, the right level of oxygen is more than 0.02 ppm, more than 0.2 ppm, more than 1.2 ppm, more than 6 ppm and even more than 12 ppm. All expressed in wt %. For some applications, excessively high levels should be avoided. In different embodiments, the right level of oxygen is less than 390 ppm, less than 140 ppm, less than 90 ppm, less than 49 ppm, less than 19 ppm, less than 9 ppm and even less than 4 ppm. All expressed in wt %. As disclosed in other parts of this document, for some applications, the presence of very high oxygen contents in the metallic part of the component is preferred. In different embodiments, the right level of oxygen is 260 ppm or more, 520 ppm or more, 1100 ppm or more, 2500 ppm or more, 4100 ppm or more, 5200 ppm or more and even 8400 ppm or more. All expressed in wt %. For certain applications, excessively high levels are detrimental. In different embodiments, the right level of oxygen is 19000 ppm or less, 14000 ppm or less, 9000 ppm or less, 7900 ppm or less, 4800 ppm or less and even 900 ppm or less. All expressed in wt %. In an embodiment, the right level of oxygen, refers to the right level of oxygen in the metallic part of the component. All the embodiments disclosed above can be combined among them in any combination, provided that they are not mutually exclusive, for example: in an embodiment, the oxygen level of the metallic part of the component is set to more than 0.02 ppm and less than 390 ppm: or for example: in another embodiment, the oxygen level of the metallic part of the component is set between 260 ppm and 19000 ppm; or for example: in another embodiment, the oxygen level of the metallic part of the component is set to more than 0.02 ppm and less than 390 ppm, and the nitrogen level of the metallic part of the component is set to more than 0.01 ppm and less than 99 ppm.

For some applications, the fixing step is made taking good care to preserve the % NMVS and/or the % NMVC in the metallic part of the component during the fixing step. In an embodiment, the metallic part of the component has the proper level of % NMVS (the proper level of % NMVS as previously defined) after applying the fixing step. In an embodiment, the metallic part of the component has the proper level of % NMVC (the proper level of % NMVC as previously defined) after applying the fixing step. The inventor has found that for certain applications, particularly when an % O₂ comprising atmosphere at the right temperature for the right time (as previously defined) is applied at least in part of the fixing step the % NMVC level in the metallic part of the component may be very relevant. In different embodiments, the % NMVC in the metallic part of the component after applying the fixing step is above 0.4%, above 2.1%, above 4.2%, above 6%, above 11%, above 16% and even above 22%. For some applications, the % NMVC should be maintained below a certain level. In different embodiments, the % NMVC in the metallic part of the component after applying the fixing step is below 64%, below 49%, below 39%, below 14%, below 9% and even below 4%. In an alternative embodiment, the % NMVC levels disclosed above, refer to the % NMVC levels in the metallic part of the component at the time the % O₂ comprising atmosphere at the right temperature for the right time (as previously defined) is removed. Often, the method can be interrupted to measure the % NMVS and/or % NMVC in the metallic part of the component and make sure the levels are as required.

The inventor has found that for some applications it is advantageous to apply a machining step after applying the fixing step. In an embodiment, the method further comprises the step of: applying a machining to the component obtained after applying the fixing step.

The inventor has found that for some applications it is advantageous to apply an additional step to make bigger components. In an embodiment, the method further comprises the step of: joint different parts to make a bigger component (as previously defined) before applying the consolidation step.

In some embodiments, the component obtained is then subjected to a consolidation treatment. The step of: applying a consolidation method is also referred throughout the present method as the consolidation step. In an embodiment, the consolidation method applied in the consolidation step comprises applying a sintering. In some embodiments, the sintering technique employed is spark plasma sintering (this may also be applied throughout in the document when reference is made to a sintering). In some particular embodiments, the consolidation step comprises the application of “a high pressure, high temperature cycle where the pressure is strongly variated during the cycle presenting at least two high pressure periods in two different moments in time” (as defined in this document). For some applications, when the AM method employed in the forming step comprises the use of an organic material such as, but not limited to, a polymer and/or a binder, the consolidation step may comprise a debinding step to eliminate at least part of the organic material. In some embodiments, at least part of the elimination of the organic material takes place during the consolidation step. For some applications, the debinding step and the consolidation step are performed simultaneously and/or in the same furnace or pressure vessel. In an embodiment, the debinding and the consolidation step are performed in the same furnace or pressure vessel. In an embodiment, the debinding and the consolidation step are performed simultaneously. In some embodiments, the consolidation treatment applied in the consolidation step comprises a debinding and a sintering. Even, in some particular embodiments, the consolidation step can be extremely simplified and reduced to a debinding step.

As previously disclosed, the inventor has found that for some applications, it is advantageous to perform the fixing step and the consolidation step simultaneously and/or in the same furnace or pressure vessel. In an embodiment, the fixing step and the consolidation step are performed in the same furnace or pressure vessel. In an embodiment, the fixing step and the consolidation step are performed simultaneously (hereinafter referred as the combined step). In an embodiment, when the fixing step and the consolidation step are performed simultaneously, the % NMVS in the metallic part of the component after applying the fixing step, the % NMVC in the metallic part of the component after applying the fixing step, the apparent density of the metallic part of the component after applying the fixing step, the right level of oxygen in the metallic part of the component after applying the fixing step and the right level of nitrogen in the metallic part of the component after applying the fixing step (as previously defined) are reached at some point of the combined step. For some applications, the above disclosed for the combined step may also be extended to other embodiments, where other method steps (such as, but not limited to, the debinding step and/or the densification step) are performed simultaneously with the fixing step and/or the consolidation step: in such embodiments, the % NMVS in the metallic part of the component after applying the fixing step, the % NMVC in the metallic part of the component after applying the fixing step, the apparent density of the metallic part of the component after applying the fixing step, the right level of oxygen in the metallic part of the component after applying the fixing step and the right level of nitrogen in the metallic part of the component after applying the fixing step (as previously defined) are reached at some point of the corresponding combined steps.

For some applications, the atmosphere used in the furnace or pressure vessel where the consolidation step is performed is relevant. Accordingly, in some embodiments, it is important to correctly choose the atmosphere in the consolidation step to achieve the desirable performance of the manufactured component. In an embodiment, the consolidation step takes place in a properly designed atmosphere (as previously defined). In an embodiment, the consolidation step comprises the use of a properly designed atmosphere. For certain applications, it is advantageous to change the atmosphere used during the consolidation step (such as, but not limited to, the use of a properly designed atmosphere only in a part of the consolidation step and/or the use of at least two different properly designed atmospheres in the consolidation step). In an embodiment, a properly designed atmosphere is used to perform at least part of the consolidation step. Accordingly, any embodiment that relates to a properly designed atmosphere disclosed in this document can be combined with the consolidation step in any combination, provided that they are not mutually exclusive. In an embodiment, the consolidation step comprises the use of at least 2 different atmospheres. In another embodiment, the consolidation step comprises the use of at least 3 different atmospheres. In another embodiment, the consolidation step comprises the use of at least 4 different atmospheres. For certain applications, it is advantageous to use a right carbon potential of the furnace or pressure vessel atmosphere in relation to the carbon potential of the surface of the component (as previously defined) in the consolidation step. In an embodiment, the consolidation step comprises the use of a right carbon potential of the furnace or pressure vessel atmosphere in relation to the carbon potential of the surface of the component (as previously defined). Accordingly, any embodiment that relates to a right carbon potential of the furnace or pressure vessel atmosphere in relation to the carbon potential of the surface of the component disclosed in this document can be combined with the consolidation step in any combination, provided that they are not mutually exclusive. For certain applications, it is advantageous to use a right carbon potential of the furnace or pressure vessel atmosphere in relation to the carbon content in the metallic part of the component (as previously defined) after applying the consolidation step. In an embodiment, the consolidation step comprises the use of a right carbon potential of the furnace or pressure vessel atmosphere in relation to the carbon content in the metallic part of the component (as previously defined) after applying the consolidation step. The carbon potential of the furnace or pressure vessel atmosphere in relation to the carbon content in the metallic part of the component after applying the consolidation step is defined as the absolute value of [(carbon content in the metallic part of the component after applying the consolidation step—carbon potential of the furnace or pressure vessel atmosphere)/carbon potential of the furnace or pressure vessel atmosphere]*100. Accordingly, any embodiment that relates to a right carbon potential of the furnace or pressure vessel atmosphere in relation to the carbon content in the metallic part of the component disclosed in this document can be combined with the consolidation step, provided that they are not mutually exclusive. For certain applications, the use of a right nitriding atmosphere (as previously defined) is advantageous. In an embodiment, the consolidation step comprises the use of a right nitriding atmosphere (as previously defined). Accordingly, any embodiment that relates to a right nitriding atmosphere disclosed in this document can be combined with the consolidation step, provided that they are not mutually exclusive. The inventor has found that for some applications, the use of a right nitriding atmosphere (as previously defined) comprising the application of a high nitriding temperature (as previously defined) in combination with the application of overpressure (as previously defined) and/or certain vacuum (as previously defined) in the consolidation step is particularly advantageous. For some applications, what is more relevant is the weight percentage of nitrogen at the surface of the component after applying the consolidation step. For a given composition of the powder, the skilled in the art knows how to select the temperature, nitriding potential and other relevant variables, so that according to simulation, the weight percentage of nitrogen (% N) at the surface after applying the consolidation step is the right nitrogen content (as previously defined). In an embodiment, simulation is performed with ThermoCal (version 2020b). In an embodiment, the weight percentage of nitrogen at the surface after applying the consolidation step is the right nitrogen content (as previously defined). Accordingly, any embodiment that relates to the right nitrogen content disclosed in this document can be combined with the consolidation step in any combination, provided that they are not mutually exclusive. In an embodiment, the consolidation step comprises the use of an % O₂ comprising atmosphere at the right temperature for the right time (as previously defined). Accordingly, any embodiment that relates to an % O₂ comprising atmosphere at the right temperature for the right time disclosed in this document can be combined with the consolidation step in any combination, provided that they are not mutually exclusive. In an embodiment, the consolidation step comprises the application of a high vacuum level (as previously defined). Accordingly, any embodiment that relates to a high vacuum level disclosed in this document can be combined with the consolidation step in any combination, provided that they are not mutually exclusive.

As explained throughout, for some applications it is desirable to use a properly designed atmosphere comprising the application of vacuum which can in some cases lead to high densities and even full density (the maximum theoretical density). For some applications, it is advantageous to use a properly designed atmosphere (as previously defined) comprising the application of a high vacuum level (as previously defined) in the consolidation step. In this regard, any embodiment that relates to a high vacuum level disclosed in this document can be combined with the consolidation step in any combination, provided that they are not mutually exclusive.

It has been found that for some applications, performing the consolidation step under pressure may help to achieve very high densities and even full density (the maximum theoretical density). In different embodiments, the pressure in the consolidation step is at least 1 mbar, at least 10 mbar, at least 0.1 bar, at least 1.6 bar, at least 10.1 bar, at least 21 bar and even at least 61 bar. For some applications, the pressure in the consolidation step should be maintained below a certain value. In different embodiments, the pressure in the consolidation step is less than 4900 bar, less than 790 bar, less than 89 bar, less than 8 bar, less than 1.4 bar and even less than 800 mbar. The inventor has found that for some applications, the consolidation step is advantageously performed at a pressure under atmospheric pressure. In an embodiment, the pressure in the consolidation step refers to the maximum pressure applied in the consolidation step. In an alternative embodiment, the pressure in the consolidation step refers to the mean pressure applied in the consolidation step. In another alternative embodiment, the mean pressure is calculated excluding any pressure which is maintained for less than a “critical time” (as previously defined).

For some applications, it is important to correctly choose the temperature applied in the consolidation step. In different embodiments, the temperature in the consolidation step is 0.36*Tm or more, 0.46*Tm or more, 0.54*Tm or more, 0.66*Tm or more, being Tm the melting temperature of the metallic powder with the lowest melting point in the powder mixture. For some applications, even higher temperatures are preferred. In different embodiments, the temperature in the consolidation step is 0.72*Tm or more, 0.76*Tm or more and even 0.89*Tm or more, being Tm the melting temperature of the metallic powder with the lowest melting point in the powder mixture. It has been surprisingly found that for some applications, it is advantageous to keep a temperature rather low in the consolidation step. In different embodiments, the temperature in the consolidation step is 0.96*Tm or less, 0.88*Tm or less, 0.78*Tm or less, 0.68*Tm or less and even 0.63*Tm or less, being Tm the melting temperature of the metallic powder with the lowest melting point in the powder mixture. In an alternative embodiment. Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment. Tm is the mean melting temperature of the metal comprising powder mixture (volume-weighted arithmetic mean, where the weights are the volume fractions). In other alternative embodiments, Tm refers to the melting temperature of a powder mixture (as previously defined). For some applications, when only one metallic powder is used, Tm is the melting temperature of the metallic powder. In this context, the temperatures disclosed above are in kelvin. In an embodiment, the temperature in the consolidation step refers to the maximum temperature in the consolidation step. In an alternative embodiment, the temperature in the consolidation step refers to the mean temperature in the consolidation step. In another alternative embodiment, the mean temperature is calculated excluding any temperature which is maintained for less than a “critical time” (as previously defined).

For some applications, it can be acceptable, and even advantageous the presence of certain liquid phase during the consolidation in the consolidation step. In such cases even higher temperatures can be applied in the consolidation step. In different embodiments, the temperature in the consolidation step is 0.96*Tm or more, Tm or more, 1.02*Tm or more, 1.06*Tm or more, 1.12*Tm or more, 1.25*Tm or more and even 1.3*Tm or more, being Tm the melting temperature of the metallic powder with the lowest melting point in the powder mixture. For some applications, it is better to define the temperature in the consolidation step in overheating terms. In different embodiments, the temperature in the consolidation step is Tm+1 or more, Tm+11 or more. Tm+22 or more, Tm+51 or more, Tm+105 or more, Tm+205 or more and even Tm+405 or more, being Tm the melting temperature of the metallic powder with the lowest melting point in the powder mixture. It has been found that for some applications, it is advantageous to keep the temperature in the consolidation step below a certain value. In different embodiments, the temperature in the consolidation step is 1.9*Tm or less, 1.49*Tm or less, 1.29*Tm or less and even 1.19*Tm or less, being Tm the melting temperature of the metallic powder with the lowest melting point in the powder mixture. In different embodiments, the temperature in the consolidation step is Tm+890 or less, Tm+450 or less, Tm+290 or less, Tm+190 or less and even Tm+90 or less, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In another alternative embodiment, Tm refers to the melting temperature of a powder mixture (as previously defined). For some applications, when only one metallic powder is used, Tm is the melting temperature of the metallic powder. In this context, the temperatures disclosed above are in kelvin. In an embodiment, the temperature in the consolidation step refers to the maximum temperature in the consolidation step. In an alternative embodiment, the temperature in the consolidation step refers to the mean temperature in the consolidation step. In another alternative embodiment, the mean temperature is calculated excluding any temperature which is maintained for less than a “critical time” (as previously defined). For some of these applications, what is more relevant is the percentage of liquid phase. In different embodiments, the maximum liquid phase during the consolidation step is above 0.2 vol %, above 1.2 vol %, above 3.6 vol %, above 6 vol %, above 11 vol % and even above 21 vol %. For some applications, particularly when the presence of certain liquid phase is preferred, the liquid phase formed should be maintained below a certain value. In different embodiments, the liquid phase at any moment during the consolidation step is maintained below 39 vol %, below 29 vol %, below 19 vol %, below 9 vol % and even below 4 vol %.

The inventor has found, that for some applications, the use of the treatment of “consolidation to high densities”, as previously defined, may be also advantageous. In an embodiment, the consolidation step comprises applying a treatment of “consolidation to high densities” (as previously defined).

For some applications, the oxygen and/or nitrogen level of the metallic part of the component after applying the consolidation step is relevant to mechanical properties. In an embodiment, the metallic part of the component has the right level of oxygen after applying the consolidation step, being the right level of oxygen as previously defined. In an embodiment, the metallic part of the component has the right level of nitrogen after applying the consolidation step, being the right level of nitrogen as previously defined.

For some applications, it is particularly advantageous to achieve a certain apparent density after applying the consolidation step. In different embodiments, the apparent density of the metallic part of the component after applying the consolidation step is higher than 81%, higher than 86%, higher than 91%, higher than 94.2%, higher than 96.4%, higher than 99.4% and even full density. Surprisingly, it has been found that for some applications, excessively high apparent densities may be detrimental. In different embodiments, the apparent density of the metallic part of the component after applying the consolidation step is less than 99.8%, less than 99.6%, less than 99.4%, less than 98.9%, less than 97.4%, less than 93.9% and even less than 89%. For certain applications what is more relevant is the percentage of increase of the apparent density of the metallic part of the component after applying the consolidation step, being the percentage of increase defined as the absolute value of [(apparent density after applying the consolidation step—apparent density after applying the forming step)/apparent density after applying the consolidation step]*100. In an embodiment, apparent density refers to apparent density of the metallic part of the component. In different embodiments, the percentage of increase of the apparent density of the metallic part of the component after applying the consolidation step is below 29%, below 19%, below 14%, below 9%, below 4%, below 2% and even below 0.9%. The inventor has found that for some applications a certain increase of the apparent density is preferred. In different embodiments, the percentage of increase of the apparent density of the metallic part of the component after applying the consolidation step is above 6%, above 11%, above 16%, above 22%, above 32% and even above 42%. For some these applications, the percentage of increase of the apparent density of the metallic part of the component after applying the consolidation step should be kept below a certain value. In different embodiments, the percentage of increase of the apparent density of the metallic part of the component after applying the consolidation step is below 69%, below 59%, below 49% and even below 34%. All the embodiments disclosed above can be combined among them in any combination, provided that they are not mutually exclusive, for example: in an embodiment, the percentage of increase of the apparent density of the metallic part of the component after applying the consolidation step is above 6% and below 69%. In an alternative embodiment, the above disclosed values of percentage of increase of the apparent density are reached at some point of the consolidation step. In another alternative embodiment, the above disclosed values of percentage of increase of the apparent density are reached after applying the densification step.

For some applications, it is particularly advantageous to achieve a certain % NMVS after applying the consolidation step. The inventor has found that for some applications, the % NMVS in the metallic part of the component (as previously defined) after applying the consolidation step should be controlled properly. In different embodiments, the % NMVS in the metallic part of the component after applying the consolidation step is below 39%, below 24%, below 14%, below 9%, below 4% and even below 2%. For some applications, lower values are preferred and even their absence (% NMVS=0). On the other hand, some applications benefit from the presence of certain % NMVS. In different embodiments, the % NMVS in the metallic part of the component after applying the consolidation step is above 0.02%, above 0.06%, above 0.2% k, above 0.6%, above 1.1% and even above 3.1%. All the embodiments disclosed above can be combined among them in any combination, provided that they are not mutually exclusive, for example: in an embodiment, the % NMVS in the metallic part of the component after applying the consolidation step is above 0.02% and below 39%. In an alternative embodiment, the above disclosed values of % NMVS are reached at some point of the consolidation step. In another alternative embodiment, the above disclosed values of % NMVS are reached after applying the densification step. For some applications what is more relevant is the percentage of reduction of NMVS after applying the consolidation step. In this regard, the percentage of reduction of NMVS in the metallic part of the component after applying the consolidation step [(total % NMVT in the component after applying the consolidation step*% NMVS in the component after applying the consolidation step)/(total % NMVT in the component after applying the forming step *% NMVS in the component after applying the forming step)]*100, being the total % NMVT in the component=100%-apparent density (being the apparent density in percentage). In an embodiment, % NMVT in the component refers to % NMVT in the metallic part of the component. In an embodiment, % NMVS in the component refers to % NMVS in the metallic part of the component. In an embodiment, apparent density refers to apparent density of the metallic part of the component. In different embodiments, the percentage of reduction of NMVS in the metallic part of the component after applying the consolidation step is above 0.12%, above 0.6%, above 2.1%, above 6%, above 11%, above 26%, above 51%, above 81% and even above 96%. The inventor has found that for some applications, there is a certain relation between the percentage of reduction of NMVS in the metallic part of the component after applying the consolidation step and the AM process temperature employed (as previously defined) in the forming step. In different embodiments, when the AM process temperature (as previously defined) employed in the forming step is below the reference temperature (as previously defined), the percentage of reduction of NMVS in the metallic part of the component after applying the consolidation step is above 2.1%, above 6%, above 11%, above 26%, above 51%, above 81% and even above 96%. The above disclosed about the percentage of reduction of NMVS in the metallic part of the component after applying the consolidation step when the AM process temperature (as previously defined) employed in the forming step is below the reference temperature (as previously defined) may also be applied to the AM methods comprising the use of an organic material. As previously disclosed, for some applications an AM process temperature equal to or above the reference temperature (as previously defined) is preferred. In different embodiments, when the AM process temperature (as previously defined) employed in the forming step is equal to or above the reference temperature (as previously defined), the percentage of reduction of NMVS in the metallic part of the component after applying the consolidation step is above 0.12%, above 0.6%, above 2.1%, above 6%, above 11%, above 51% and even above 81%. All the embodiments disclosed above can be combined among them in any combination, provided that they are not mutually exclusive, for example: in an embodiment, the percentage of reduction of NMVS in the metallic part of the component after applying the consolidation step is above 0.12%; or for example in another embodiment, the maximum temperature employed in the AM method is equal to or above 0.36*Tm, being Tm the melting temperature of the metallic powder with the lowest melting point in the powder mixture, and the percentage of reduction of NMVS in the metallic part of the component after applying the consolidation step is above 0.12%; or for example: in another embodiment, the mean shaping temperature employed in the AM method is below 0.64*Tm, being Tm the melting temperature of the metallic powder with the lowest melting point in the powder mixture, and the percentage of reduction of NMVS in the metallic part of the component after applying the consolidation step is above 2.1%. In an alternative embodiment, the above disclosed values of percentage of reduction of are reached at some point of the consolidation step. In another alternative embodiment, the above disclosed values of percentage of reduction of NMVS are reached after applying the densification step.

For some applications, it is particularly advantageous to achieve a certain % NMVC after applying the consolidation step. The inventor has found that for some applications, the % NMVC in the metallic part of the component (the % NMVC as previously defined) after applying the consolidation step should be controlled properly. In different embodiments, the % NMVC in the metallic part of the component after applying the consolidation step is below 9%, below 4%, below 0.9%, below 0.4% and even below 0.09%. For some applications, lower values are preferred and even their absence (% NMVC=0). On the other hand, some applications benefit from the presence of certain % NMVC in the metallic part of the component after applying the consolidation step. In different embodiments, the % NMVC in the metallic part of the component after applying the consolidation step is above 0.002%, above 0.006%, above 0.02% k, above 0.6%, above 1.1% and even above 3.1%. All the embodiments disclosed above can be combined among them in any combination, provided that they are not mutually exclusive, for example: in an embodiment, the % NMVC in the metallic part of the component after applying the consolidation step is above 0.002% k and below 9% k. In an alternative embodiment, the above disclosed values of % NMVC are reached at some point of the consolidation step. In another alternative embodiment, the above disclosed values of % NMVC are reached after applying the densification step.

The inventor has found that for some applications it is advantageous to apply a machining after applying the consolidation step. In an embodiment, the method further comprises the step of: applying a machining to the component obtained after applying the consolidation step.

The inventor has found that for some applications it is advantageous to apply an additional step to make bigger components after applying the consolidation step. In an embodiment, the method further comprises the step of: joint different parts to make a bigger component (as previously defined) before applying the densification step.

In some embodiments, the component can be subjected to a densification step comprising the application of high temperatures and/or high pressures. In an embodiment, the component obtained in the consolidation step is further subjected to a high temperature, high pressure treatment. The step of: applying a high temperature, high pressure treatment is also referred throughout the present method as the densification step. In an embodiment, the method comprises the following steps: —providing a powder or powder mixture; —applying an additive manufacturing method to form the component; —optionally, applying a pressure and/or temperature treatment; —applying a debinding; —optionally, applying a pressure and/or temperature treatment; -setting the nitrogen and/or oxygen level of the metallic part of the component; —applying a consolidation treatment; and —applying a high temperature, high pressure treatment.

In an embodiment, the fixing stop is performed simultaneously with the consolidation step and the densification step. In an embodiment, the fixing step, the consolidation step and the densification step are performed in the same furnace or pressure vessel. In an embodiment, the consolidation step and densification step are performed simultaneously. In an embodiment, the consolidation step and the densification step are performed in the same furnace or pressure vessel. For some applications, the consolidation step is optional and therefore can be avoided. In an embodiment, the consolidation step is skipped. In an embodiment the densification step is applied instead of the consolidation step. The inventor has found that some applications benefit from the application of the pressure in a homogeneous way as previously defined in this document. In an embodiment the densification step comprises applying the “strategies developed for the application of pressure in a homogeneous way”. The inventor has also found that for some applications, it is particularly advantageous to perform at least part of the heating using microwaves. In an embodiment, the densification step comprises applying a “microwave heating” (as previously defined). In an embodiment, the densification step comprises the application of vacuum at a high vacuum level (as previously defined) prior to apply pressure. In an embodiment, the densification step comprises the application of a hot isostatic pressing (HIP). In another embodiment, the densification step is a hot isostatic pressing (HIP). Alternatively, for some applications, any other densification method can be applied in the densification step. In an embodiment, the densification step comprises the application of “a high pressure, high temperature cycle where the pressure is strongly variated during the cycle presenting at least two high pressure periods in two different moments in time” (as defined in this document). In an embodiment, this cycle and the densification step are performed simultaneously. In an embodiment, this cycle and the consolidation step are performed in the same furnace or pressure vessel. In an embodiment, this cycle, the consolidation step and the densification step are performed simultaneously. In an embodiment, this cycle, the consolidation step and the densification step are performed in the same furnace or pressure vessel. The inventor has found that for some applications, it is advantageous to apply a fast enough cooling (as defined in this document) in the densification step. In an embodiment the densification step comprises a fast enough cooling. Accordingly, any embodiment that relates to a fast enough cooling disclosed in this document can be combined with the densification step in any combination, provided that they are not mutually exclusive. In an embodiment, the fast enough cooling and the densification step are performed simultaneously. In an embodiment, the fast enough cooling, the consolidation step and the densification step are performed simultaneously.

In an embodiment the method step which comprises applying a high temperature, high pressure treatment is applied more than once. In an embodiment, at least 2 high temperature, high pressure treatments are applied. In another embodiment, at least 3 high temperature, high pressure treatments are applied.

For some applications, the atmosphere used in the furnace or pressure vessel where the densification step is performed is relevant. Accordingly, in some embodiments, it is important to correctly choose the atmosphere in the densification step to achieve the desirable performance of the manufactured component. In an embodiment, the densification step comprises the use of a properly designed atmosphere (as previously defined). For certain applications, it is advantageous to change the atmosphere used during the densification step (such as, but not limited to, the use of a properly designed atmosphere only in a part of the densification step and/or the use of at least two different properly designed atmospheres in the densification step). In an embodiment, a properly designed atmosphere is used to perform at least part of the densification step. Accordingly, any embodiment that relates to a properly designed atmosphere disclosed in this document can be combined with the densification step in any combination, provided that they are not mutually exclusive. In an embodiment, the densification step comprises the use of at least 2 different atmospheres. In another embodiment, the densification step comprises the use of at least 3 different atmospheres. In another embodiment, the densification step comprises the use of at least 4 different atmospheres. For certain applications, it is advantageous to use a right carbon potential of the furnace or pressure vessel atmosphere in relation to the carbon potential of the surface of the component (as previously defined) in the densification step. In an embodiment, the densification step comprises the use of a right carbon potential of the furnace or pressure vessel atmosphere in relation to the carbon potential of the surface of the component (as previously defined). Accordingly, any embodiment that relates to a right carbon potential of the furnace or pressure vessel atmosphere in relation to the carbon potential of the surface of the component disclosed in this document can be combined with the densification step in any combination, provided that they are not mutually exclusive. For certain applications, it is advantageous to use a right carbon potential of the furnace or pressure vessel atmosphere in relation to the carbon content in the metallic part of the component (as previously defined) after applying the densification step. In an embodiment, the densification step comprises the use of a right carbon potential of the furnace or pressure vessel atmosphere in relation to the carbon content in the metallic part of the component (as previously defined) after applying the densification step. The carbon potential of the furnace or pressure vessel atmosphere in relation to the carbon content in the metallic part of the component after applying the densification step is defined as the absolute value of [(carbon content in the metallic part of the component after applying the densification step—carbon potential of the furnace or pressure vessel atmosphere)/carbon potential of the furnace or pressure vessel atmosphere]*100. Accordingly, any embodiment that relates to a right carbon potential of the furnace or pressure vessel atmosphere in relation to the carbon content in the metallic part of the component disclosed in this document can be combined with the densification step in any combination, provided that they are not mutually exclusive. For certain applications, the use of a right nitriding atmosphere (as previously defined) in the densification step is advantageous. In an embodiment, the densification step comprises the use of a right nitriding atmosphere. Accordingly, any embodiment that relates to a right nitriding atmosphere disclosed in this document can be combined with the densification step in any combination, provided that they are not mutually exclusive. The inventor has found that for some applications, it is particularly advantageous the use of a right nitriding atmosphere comprising the application of a high nitriding temperature in combination with the application of overpressure and/or certain vacuum (as previously defined) in the densification step. For some applications, what is more relevant is the weight percentage of nitrogen at the surface of the component after applying the densification step. For a given composition of the powder, the skilled in the art knows how to select the temperature, nitriding potential and other relevant variables, so that according to simulation, the weight percentage of nitrogen (% N) at the surface after applying the densification step is the right nitrogen content (as previously defined). In an embodiment, simulation is performed with ThermoCal (version 2020b). In an embodiment, the weight percentage of nitrogen at the surface after applying the densification step is the right nitrogen content (as previously defined). Accordingly, any embodiment that relates to the right nitrogen content disclosed in this document can be combined with the densification step in any combination, provided that they are not mutually exclusive. For certain applications, the use of an % O₂ comprising atmosphere at the right temperature for the right time (as previously defined) in the densification step is advantageous. In an embodiment, the densification step comprises the use of an % O₂ comprising atmosphere at the right temperature for the right time. Accordingly, any embodiment that relates to an % O₂ comprising atmosphere at the right temperature for the right time disclosed in this document can be combined with the densification step in any combination, provided that they are not mutually exclusive. In an embodiment, the atmosphere used in the densification step comprises the application of a high vacuum level (as previously defined). Accordingly, any embodiment that relates to a high vacuum level disclosed in this document can be combined with the densification step in any combination, provided that they are not mutually exclusive. For some applications, the use of a properly designed atmosphere (as previously defined) comprising the application of a high vacuum level (as previously defined) in the densification step is preferred. In this regard, any embodiment that relates to a high vacuum level disclosed in this document can be combined with the densification step in any combination, provided that they are not mutually exclusive.

For some applications, it is important to correctly choose the pressure applied in the densification step. In different embodiments, the pressure in the high temperature, high pressure treatment is 160 bar or more, 320 bar or more, 560 bar or more, 1050 bar or more and even 1550 bar or more. For some applications, the pressure in the densification step should be maintained below a certain value. In different embodiments, the pressure in the high temperature, high pressure treatment is less than 4900 bar, less than 2800 bar, less than 2200 bar, less than 1800 bar, less than 1400 bar, less than 900 bar and even less than 490 bar. In an embodiment, the pressure in the high temperature, high pressure treatment refers to the maximum pressure applied in the pressure in the high temperature, high pressure treatment. In an alternative embodiment, the pressure in the high temperature, high pressure treatment refers to the mean pressure applied in the pressure in the high temperature, high pressure treatment. For some applications, it is important to correctly choose the temperature applied in the densification step. In different embodiments, the temperature in the high temperature, high pressure treatment is 0.45*Tm or more, 0.55*Tm or more, 0.65*Tm or more, 0.70*Tm or more, 0.75*Tm or more, 0.8*Tm or more and even 0.86*Tm or more, being Tm the melting temperature of the metallic powder with the lowest melting point in the powder mixture. As said, it has been surprisingly found that for some applications, it is advantageous to keep the temperature rather low. In different embodiments, the temperature in the high temperature, high pressure treatment is 0.92*Tm or less, 0.88*Tm or less, 0.78*Tm or less, 0.75*Tm or less and even 0.68*Tm or less, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In another alternative embodiment, Tm refers to the melting temperature of a powder mixture (as previously defined). For some applications, when only one metallic powder is used, Tm is the melting temperature of the metallic powder. In this context, the temperatures disclosed above are in kelvin. In an embodiment, the temperature in the high temperature, high pressure treatment refers to the maximum temperature applied in the pressure in the high temperature, high pressure treatment. In an alternative embodiment, the temperature in the high temperature, high pressure treatment refers to the mean temperature applied in the pressure in the high temperature, high pressure treatment. For some applications, the high temperature, high pressure treatments disclosed throughout in this document can also be applied in the present method.

For some applications, the oxygen and/or nitrogen level of the metallic part of the component after applying the densification step is relevant to mechanical properties. In an embodiment, the metallic part of the component has the right level of oxygen after applying the densification step, being the right level of oxygen as previously defined. In an embodiment, the metallic part of the component has the right level of nitrogen after applying the densification step, being the right level of nitrogen as previously defined.

For some applications, it is particularly advantageous to achieve a certain apparent density of the metallic part of the component after applying the densification step. In different embodiments, the apparent density of the metallic part of the component after applying the densification step is higher than 96%, higher than 98.2%, higher than 99.2%, higher than 99.6%, higher than 99.82%, higher than 99.96% and even full density. Surprisingly, it has been found that for some applications, excessively high apparent densities may be detrimental. In different embodiments, the apparent density of the metallic part of the component after applying the densification step is less than 99.98%, less than 99.94%, less than 99.89%, less than 99.4% and even less than 98.9%. All the embodiments disclosed above can be combined among them in any combination, provided that they are not mutually exclusive, for example: in an embodiment, the apparent density of the metallic part of the component after applying the densification step is higher than 96% and less than 99.98%. Alternatively, in some embodiments, the apparent density levels of the metallic part of the component after applying the consolidation step (as previously defined) are reached after applying the densification step. For certain applications what is more relevant is the percentage of increase of the apparent density of the metallic part of the component after applying the densification step, being the percentage of increase of the apparent density of the metallic part of the component after applying the densification step=the absolute value of [(apparent density of the component after applying the densification step—apparent density of the component after applying the forming step)/apparent density of the component after applying the densification step]*100. In an embodiment, apparent density of the component refers to apparent density of the metallic part of the component. In different embodiments, the percentage of increase of the apparent density of the metallic part of the component after applying the densification step is above 6%, above 11%, above 16%, above 22%, above 32% and even above 42%. For some these applications, the percentage of increase of the apparent density of the metallic part of the component after applying the densification step should be kept below a certain value. In different embodiments, the percentage of increase of the apparent density of the metallic part of the component after applying the densification step is below 69%, below 59%, below 49% and even below 34%. All the embodiments disclosed above can be combined among them in any combination, provided that they are not mutually exclusive, for example: in an embodiment, the percentage of increase of the apparent density of the metallic part of the component after applying the densification step is above 6% and below 69%.

The inventor has found that some applications benefit from the presence of certain % NMVS in the metallic part of the component (as previously defined) after applying the densification step. In different embodiments, the % NMVS in the metallic part of the component after applying the densification step is above 0.002%, above 0.01%, above 0.06%, above 0.1% and even above 2.1%. For some applications, the % NMVS should be controlled. In different embodiments, the % NMVS in the metallic part of the component after applying the densification step is below 29%, below 19%, below 9%, below 4% and even below 2%. For some applications, lower values are preferred and even their absence (% NMVS=0). All the embodiments disclosed above can be combined among them in any combination, provided that they are not mutually exclusive, for example: in an embodiment, the % NMVS in the metallic part of the component after applying the densification step is above 0.002% and below 29%. Alternatively, in some embodiments, the % NMVS in the metallic part of the component after applying the consolidation step (as previously defined) are reached after applying the densification step. For certain applications what is relevant is the percentage of reduction of NMVS in the metallic part of the component after applying the densification step, being the percentage of reduction of NMVS in the metallic part of the component after applying the densification step=[(total % NMVT in the component after applying the densification step*% NMVS in the component after applying the densification step)/(total % NMVT in the component after applying the forming step *% NMVS in the component after applying the forming step)]*100, wherein the total % NMVT of the component=100%-apparent density (being the apparent density in percentage). In an embodiment, % NMVT in the component refers to % NMVT in the metallic part of the component. In an embodiment, % NMVS in the component refers to % NMVS in the metallic part of the component. In an embodiment, apparent density refers to apparent density of the metallic part of the component. For some applications, the percentage of reduction of NMVS in the metallic part of the component after applying the consolidation step (the values of percentage of reduction previously disclosed in this document) are reached after applying the densification step. In different embodiments, the percentage of reduction of NMVS in the metallic part of the component after applying the densification step is above 0.02%, above 0.22%, above 2.6%, above 3.6%, above 8% and even above 12%. For certain applications higher values are preferred. In different embodiments, the percentage of reduction of NMVS in the metallic part of the component after applying the densification step is above 16%, above 32%, above 51%, above 61%, above 86% and even above 96%. The inventor has found that for some applications, there is a certain relation between the percentage of reduction of NMVS in the metallic part of the component after applying the densification step and the AM process temperature (as previously defined) employed in the forming step. In different embodiments, when the AM process temperature (as previously defined) employed in the forming step is below the reference temperature (as previously defined), the percentage of reduction of NMVS in the metallic part of the component after applying the densification step is above 3.6%, above 8%, above 16%, above 32%, above 51%, above 86% and even above 96%. The above disclosed about the percentage of reduction of NMVS in the metallic part of the component after applying the densification step when the AM process temperature (as previously defined) employed in the forming step is below the reference temperature (as previously defined) may also be applied to the AM methods comprising the use of an organic material. As previously disclosed, for some applications an AM process temperature equal to or above the reference temperature (as previously defined) is preferred. In different embodiments, when the AM process temperature (as previously defined) employed in the forming step is equal to or above the reference temperature (as previously defined), the percentage of reduction of NMVS in the metallic part of the component after applying the densification step is above 0.02%, above 0.22%, above 2.6%, above 12% even above 61%.

The inventor has found that some applications benefit from the presence of certain % NMVC in the metallic part of the component (the % NMVC as previously defined) after applying the densification step. In different embodiments, the % NMVC in the metallic part of the component after applying the densification step is above 0.002%, above 0.006%, above 0.01%, above 0.02% and even above 2.2%. For some applications, the % NMVC should be controlled. In different embodiments, the % NMVC in the metallic part of the component after applying the densification step is below 9%, below 1.9%, below 0.8% and even below 0.09%. For some applications, lower values are preferred and even their absence (% NMVC=0). All the embodiments disclosed above can be combined among them in any combination, provided that they are not mutually exclusive, for example: in an embodiment, the % NMVC in the metallic part of the component after applying the densification step is above 0.002% and below 9%. Alternatively, in some embodiments, the % NMVC in the metallic part of the component after applying the consolidation step (as previously defined) are reached after applying the densification step.

For certain applications what is more relevant is the percentage of reduction of NMVC in the metallic part of the component after applying the densification step, being the percentage of reduction of NMVC in the metallic part of the component after applying the densification step=[(total % NMVT in the component after applying the densification step*% NMVC in the component after applying the densification step)/(total % NMVT in the component after applying the forming step *% NMVC in the component after applying the forming step)]*100, wherein the total % NMVT in the component=100%-apparent density (being the apparent density in percentage). In an embodiment, % NMVT in the component refers to % NMVT in the metallic part of the component. In an embodiment, % NMVS in the component refers to % NMVS in the metallic part of the component. In an embodiment, apparent density refers to apparent density of the metallic part of the component. In different embodiments, the percentage of reduction of NMVC in the metallic part of the component after applying the densification step is above 0.06%, above 0.12%, above 0.6%, above 3.6%, above 6% and even above 8%. For certain applications, higher values are preferred. In different embodiments, the percentage of reduction of NMVC in the metallic part of the component after applying the densification step is above 16%, above 36%, above 56%, above 86% and even above 96%. For some applications, there is a certain relation between the percentage of reduction of NMVC in the metallic part of the component after applying the densification step and the “AM process temperature” (as previously defined) employed in the forming step. In different embodiments, when the AM process temperature (as previously defined) employed in the forming step is below the “reference temperature” (as previously defined), the percentage of reduction of NMVC in the metallic part of the component after applying the densification step is above 3.6%, above 8%, above 16%, above 36%, above 56%, above 86% and even above 96%. The above disclosed about the percentage of reduction of NMVC in the metallic part of the component after applying the densification step when the “AM process temperature” (as previously defined) employed in the forming step is below the “reference temperature” (as previously defined) may also be applied to the AM methods comprising the use of an organic material. As previously disclosed, for some applications an “AM process temperature” equal to or above the “reference temperature” (as previously defined) is preferred. In different embodiments, when the “AM process temperature” (as previously defined) employed in the forming step is equal to or above the reference temperature (as previously defined), the percentage of reduction of NMVC in the metallic part of the component after applying the densification step is above 0.06%, above 0.12%, above 0.6%, above 6%, above 16%, above 56% and even above 86%.

For some applications, it is advantageous to apply “a high pressure, high temperature cycle where the pressure is strongly variated during the cycle presenting at least two high pressure periods in two different moments in time” (as defined in this document) after applying the densification step. In an embodiment, this cycle and the densification step are performed simultaneously. In an embodiment, this cycle and the densification step are performed in the same furnace or pressure vessel.

The inventor has found that in some embodiments, particularly when the AM process temperature (as previously defined) employed in the forming step is equal to or above the reference temperature (as previously defined), the consolidation step and even the densification step are optionally applied.

The component obtained using the method steps disclosed in preceding paragraphs can be optionally subjected to “a high pressure, high temperature cycle where the pressure is strongly variated during the cycle presenting at least two high pressure periods in two different moments in time” (as defined in this document) after applying the densification step. In an embodiment, this cycle is applied instead the densification step.

The component obtained using the method steps disclosed in preceding paragraphs can be optionally subjected to a heat treatment to improve the mechanical properties of the manufactured component. In an embodiment, the method further comprises the step of: applying a heat treatment. In an embodiment, the densification step and the heat treatment are performed simultaneously. In an embodiment, in the densification step and the heat treatment are performed in the same furnace or pressure vessel. In an embodiment, the heat treatment comprises a thermo-mechanical treatment. For some applications it is interesting to apply a heat treatment to the manufactured components. In an embodiment, a heat treatment is applied to the manufactured components. In an embodiment, a heat treatment comprising at least one phase change is applied to the manufactured components. In an embodiment, a heat treatment comprising at least two phase changes is applied to the manufactured components. In an embodiment, a heat treatment comprising at least three phase changes is applied to the manufactured components. In an embodiment, a heat treatment comprising austenitization is applied to the manufactured components. In an embodiment, a heat treatment comprising a solubilization is applied to the manufactured components. In an embodiment, a heat treatment comprising a solubilization is applied to the manufactured components. In an embodiment, a heat treatment comprising a solubilization of a phase is applied to the manufactured components. In an embodiment, a heat treatment comprising a solubilization of an intermetallic phase is applied to the manufactured components. In an embodiment, a heat treatment comprising a solubilization of carbides is applied to the manufactured components. In an embodiment, a heat treatment comprising a high temperature exposition is applied to the manufactured components. In an embodiment high temperature means 0.52*Tm or more. In an embodiment, a heat treatment comprising a controlled cooling is applied to the manufactured components. In an embodiment, a heat treatment comprising a quench is applied to the manufactured components. In an embodiment, a heat treatment comprising a partial phase transformation is applied to the manufactured components. In an embodiment, a heat treatment comprising a martensite transformation is applied to the manufactured components. In an embodiment, a heat treatment comprising a bainitic transformation is applied to the manufactured components. In an embodiment, a heat treatment comprising a precipitation transformation is applied to the manufactured components. In an embodiment, a heat treatment comprising a precipitation of intermetallic phases transformation is applied to the manufactured components. In an embodiment, a heat treatment comprising a carbide precipitation transformation is applied to the manufactured components. In an embodiment, a heat treatment comprising an aging transformation is applied to the manufactured components. In an embodiment, a heat treatment comprising a recrystallization transformation is applied to the manufactured components. In an embodiment, a heat treatment comprising a spheroidization transformation is applied to the manufactured components. In an embodiment, a heat treatment comprising an anneal transformation is applied to the manufactured components. In an embodiment, a heat treatment comprising a tempering transformation is applied to the manufactured components. In an embodiment, the heat treatment comprises a fast enough cooling (as defined in this document). Accordingly, any embodiment that relates to a fast enough cooling disclosed in this document can be combined with the heat treatment in any combination, provided that they are not mutually exclusive.

For some applications, the application of a machining step and/or surface conditioning it is also advantageous. In an embodiment, the method further comprises the step of: applying a machining. In an embodiment, the method further comprises the step of: performing a surface conditioning (as previously defined).

In some embodiments, when the manufactured component is a metallic component with an embedded ceramic phase, it is interesting to consider this ceramic phase as a metallic part with respect to the % NMVS, the percentage of reduction of NMVS, the % NMVC, the percentage of reduction of NMVC, the apparent density and the percentage of increase of the apparent density. In some cases, when the manufactured component is a metallic component comprising a ceramic phase, it is interesting to consider this ceramic phase as a metallic part with respect to the % NMVS, the percentage of reduction of NMVS, the % NMVC, the percentage of reduction of NMVC, the apparent density and the percentage of increase of the apparent density. Accordingly, in some embodiments, when reference is made to the % NMVS in the metallic part of the component, the percentage of reduction of NMVS in the metallic part of the component, the % NMVC in the metallic part of the component, the % NMVS in the metallic part of the component, the percentage of reduction of NMVS in the metallic part of the component, the % NMVC in the metallic part of the component, the percentage of reduction of NMVC in the metallic part of the component, the apparent density of the metallic part of the component and/or the percentage of increase of the apparent density of the metallic part of the component and/or the percentage of increase of apparent density of the metallic part of the component, the wording “metallic part of the component” can be replaced by “inorganic part of the component”.

As previously disclosed, for certain applications, it is advantageous to manufacture the component using different materials. In such cases when reference is made to the content of certain elements in the metallic part of the component, in some embodiments, the wording “in the metallic part of the component” can be replaced by “in at least one material comprised in the component”.

The method disclosed in preceding paragraphs can be advantageously used to manufacture at least part of different components. In an embodiment, the component obtained applying the method disclosed above is a component with a complex geometry. In some embodiments, the whole component is manufactured using the method disclosed in the preceding paragraphs. In other embodiments, only part of the component is manufactured using the method disclosed in the preceding paragraphs. In some embodiments, when only part of the component is manufactured with the method disclosed in the preceding paragraphs, what has been disclosed for the component applies at least to the part of the component manufactured. Accordingly, in some embodiments, the wording “the component” can be replaced by “a part of the component”.

The present method can be implemented with variations to the foregoing embodiments that can meet the purpose described above. These embodiments serving the same, equivalent or similar purpose can replace the features disclosed above are all included in the technical scope of the present method unless otherwise stated.

Currently, the construction of large, high performant, additively manufactured metal comprising components is an extreme technical and economical challenge. Most existing AM technologies present excessive residual stresses and even cracks when trying to achieve large complex geometries. For several components, including several tooling, it is interesting to have a steel with a high corrosion resistance combined with very high mechanical properties, especially in terms of toughness and yield strength. Achieve the required mechanical properties is particularly challenging in metal and metal comprising components manufactured a layer by layer. In this regard, the inventor has found that metal comprising components with a high corrosion resistance combined with very high mechanical properties, especially in terms of toughness and yield strength can be additively manufactured when using a single powder or powder mixture with the overall composition disclosed below. An aspect of the invention refers to a powder or powder mixture for use in additive manufacturing (AM) having the following composition, all percentages in weight percent: % Mo: 0.05-2.9; % W: 0-3.9; % Moeq: 0.05-2.9; % Ceq: 0.002-0.14: % C: 0.002-0.09: % N: 0-2.0;% B: 0-0.08;% Si: 0.05-1.5: % Mn: 0.05-1.5;% Ni: 9.5-11.9; % Cr: 10.5-13.5;% Ti: 0.5-2.4; % Al: 0.001-1.5; % V: 0-0.4: % Nb: 0-0.9; % Zr: 0-0.9; % Hf: 0-0.9; % Ta: 0-0.9; % S: 0-0.08: % P: 0-0.08; % Pb: 0-0.9; % Cu: 0-3.9; % Bi: 0-0.08; % se: 0-0.08: % Co: 0-3.9; % REE: 0-1.4: % Y: 0-0.96; % Sc: 0-0.96: % Cs: 0-1.4; % O: 0-0.299% Y+% Sc+% REE: 0.006-1.9% rest consisting of iron and trace elements; wherein % Ceq=% C+0.86*% N+1.2*% B and % Moeq=% Mo+½*% W: and wherein % REE is as previously defined. In an embodiment, trace elements refers to several elements, unless context clearly indicates otherwise, including but not limited to: H, He. Xe, F, Ne, Na. Cl, Ar, K, Br, Kr. Sr, Tc, Ru, Rh, Pd, Ag, I, Ba, Re, Os, Ir, Pt, Au, Hg. Tl, Po, At, Rn, Fr, Ra, Rf, Db, Sg, Bh. Hs, Li, Be, Mg. Ca, Rb, Zn, Cd, Ga, In, Ge, Sn. Sb. As, Te, Ds, Rg, Cn, Nh, FI, Mc, Lv, Ts, Og and Mt. In an embodiment, trace elements comprise at least one of the elements listed above. In some embodiments, the content of any trace element is preferred below 1.8 wt %, below 0.8 wt %, below 0.3 wt %, below 0.1 wt %, below 0.09 wt % and even below 0.03 wt %. Trace elements may be added intentionally to attain a particular functionality to the steel, such as reducing the cost of production and/or its presence may be unintentional and related mostly to the presence of impurities in the alloying elements and scraps used for the production of the steel. There are several applications wherein the presence of trace elements is detrimental for the overall properties of the steel. In different embodiments, the sum of all trace elements is below 2.0 wt %, below 1.4 wt %, below 0.8 wt %, below 0.4 wt %, below 0.2 wt %, below 0.1 wt % and even below 0.06 wt %. There are even some embodiments for a given application wherein trace elements are preferred being absent from the steel. In contrast, there are several applications wherein the presence of trace elements is preferred. In different embodiments, the sum of all trace elements is above 0.0012 wt %, above 0.012 wt %, above 0.06 wt %, above 0.12 wt % and even above 0.55 wt %. For applications requiring improved wear resistance even higher % C contents are preferred. In different embodiments, % C is above 0.009 wt %, above 0.02 wt %, above 0.021 wt %, above 0.03 wt %, above 0.05 wt %, above 0.06 wt % and even above 0.07 wt %. For some applications, an excessive content of % C may adversely affect the mechanical properties. In different embodiments, % C is below 0.08 wt %, below 0.05 wt %, below 0.02 wt, below 0.01 wt % and even below 0.009 wt %. As previously disclosed, some applications benefit from a low interstitial content level in the generalized way already exposed, but some applications present even better results with somewhat different control over the level of interstitials. In different embodiments, % C is kept below 990 ppm, below 890 ppm, below 490 ppm, below 196 ppm and even below 96 ppm. For some applications, it is desirable to have higher levels of % Ceq. In different embodiments, % Ceq is above 0.006 wt %, above 0.01 wt %, above 0.02 wt %, above 0.021 wt %, above 0.09 wt %, above 0.1 wt % and even above 0.11 wt %. On the other hand, for some applications, an excessive content of % Ceq may adversely affect the mechanical properties. In different embodiments, % Ceq is below 0.12 wt %, below 0.1 wt %, below 0.02 wt %, below 0.009 wt % and even below 0.0009 wt %. As previously disclosed, some applications benefit from a low interstitial content level in the generalized way already exposed, but some applications present even better results with somewhat different control over the level of interstitials. In different embodiments, % Ceq is kept below 890 ppm, below 490 ppm, below 90 ppm and even below 40 ppm. For some applications, the presence of % N is desirable, while in other applications it is rather an impurity. In different embodiments, % N is above 0.0002 wt %, above 0.005 wt %, above 0.025 wt %, above 0.06 wt %, above 0.15 wt % and even above 0.2 wt %. For some applications, higher % N contents are preferred. In different embodiments, % N is above 0.26 wt %, above 0.31 wt %, above 0.4 wt %, above 0.46 wt %, above 0.56 wt % and even above 0.71 wt %. For some applications, even higher % N contents are preferred. In different embodiments, % N is above 0.81 wt %, above 0.91 wt %, above 1.1 wt %, above 1.31 wt % and even above 1.56 wt %. On the other hand, for some applications, excessive % N seems to deteriorate the mechanical properties. In different embodiments, % N is below 1.79 wt %, below 1.49 wt %, below 1.19 wt %, below 0.98 wt %, below 0.9 wt % and even below 0.84 wt %. For some applications, lower % N contents are preferred. In different embodiments, % N is below 0.79 wt %, below 0.74 wt %, below 0.69 wt %, below 0.59 wt %, below 0.49 t % and even below 0.39 wt %. For some applications, even lower % N contents are preferred. In different embodiments, % N is below 0.29 wt %, below 0.12 wt %, below 0.1 wt %, below 0.08 wt %, below 0.02 wt % and even below 0.002 wt %. As previously disclosed, some applications benefit from a low interstitial content level in the generalized way already exposed, but some applications present even better results with somewhat different control over the level of interstitials. In different embodiments, % N is kept below 1900 ppm, below 900 ppm, below 490 ppm, below 190 ppm and even below 40 ppm. Obviously, there are cases where the desired nominal content is 0 wt % or nominal absence of the element as occurs with all optional elements for certain applications. The inventor has surprisingly found that for some applications, small amounts of % B have a positive effect on increasing thermal conductivity. In different embodiments, % B is above 2 ppm, above 16 ppm, above 61 ppm, above 86 ppm and even above 126 ppm. For some applications, higher % B contents are preferred. In different embodiments. % Bis above 156 ppm, above 206 ppm, above 326 ppm and even above 0.04 wt %. On the other hand, the effect on the toughness can be quite detrimental if excessive borides are formed. In different embodiments. % B is below 0.06 wt %, below 0.04 wt %, below 0.03 wt %, below 0.02 wt % and even below 0.01 wt %. For some applications, lower % B contents are preferred. In different embodiments, % B is below 74 ppm, below 49 ppm, below 14 ppm, below 8 ppm and even below 4 ppm. It has been surprisingly found, that when the proper geometrical design strategy is employed great results can be achieved by having a controlled level of % B which is intentional. In different embodiments, % B is kept above 1 ppm, above 11 ppm, above 21 ppm, above 31 ppm and even above 51 ppm. For some applications, it has been found that the final properties of the component, can be surprisingly improved by the usage of rather high % B contents. In different embodiments. % B is kept above 61 ppm, above 111 ppm, above 221 ppm, above 0.06 wt %, above 0.12 wt %, above 0.26 wt % and even above 0.6 wt %. Even in some of those applications, an excessive % B content ends up being detrimental. In different embodiments, % B is kept below 0.4 wt %, below 0.19 wt %, below 0.09 wt % and even below 0.04 wt %. For some applications, excessive % B seems to deteriorate the mechanical properties. In different embodiments, % B is kept below 400 ppm, below 190 ppm, below 90 ppm, below 40 ppm and even below 9 ppm. Obviously, there are cases where the desired nominal content is 0 wt % or nominal absence of the element as occurs with all optional elements for certain applications. For some applications, higher % Si contents are preferred. In different embodiments. % Si is above 0.06 wt %, above 0.09 wt %, above 0.26 wt %, above 0.39 wt % above 0.51 wt % and even above 0.76 wt %. For some applications, even higher % Si contents are preferred. In different embodiments. % Si is above 0.8 wt %, above 0.86 wt %, above 1.1 wt %, above 1.16 wt % and even above 1.26 wt %. For some applications, excessive % Si seems to deteriorate the mechanical properties. In different embodiments, % Si is below 1.4 wt %, below 1.2 wt %, below 1.1 wt %, below 0.98 wt % and even below 0.8 wt %. For some applications, lower % Si contents are preferred. In different embodiments, % Si is below 0.6 wt %, below 0.4 wt %, below 0.39 wt %, below 0.24 wt % and even below 0.09 wt %. The inventor has surprisingly found that for some applications, low % Mn contents have a positive effect on mechanical properties. In different embodiments, % Mn is above 0.06 wt %, above 0.07 wt %, above 0.09 wt %, above 0.1 wt %, above 0.16 wt %, above 0.26 wt %, above 0.5 wt % and even above 0.66 wt %. For some applications, higher % Mn contents are preferred. In different embodiments, % Mn is above 0.51 wt %, above 0.65 wt %, above 0.76 wt %, above 1.1 wt % and even above 1.26 wt %. For some applications, excessive % Mn seems to deteriorate the mechanical properties. In different embodiments, % Mn is below 1.4 wt %, below 1.2 wt %, below 0.9 wt %, below 0.69 wt % and even below 0.5 wt %. For some applications, lower % Mn contents are preferred. In different embodiments, % Mn is below 0.49 wt %, below 0.24 wt %, below 0.1 wt %, below 0.09 wt % and even below 0.04 wt %. For some applications, excessive % Ni seems to deteriorate the mechanical properties. In different embodiments, % Ni is below 11.4 wt %, below 10.9 wt %, below 10.6 wt %, below 10.5 wt %, below 10 wt % and even below 9.9 wt %. The inventor has surprisingly found that for some applications, higher % Ni contents have a positive effect on mechanical properties. In different embodiments, % Ni is above 10.0 wt %, above 10.1 wt %, above 10.5 wt %, above 10.6 wt %, above 11.1 wt % and even above 11.3 wt %. For some applications, the presence of higher % Cr contents is preferred. In different embodiments, % Cr is above 10.6 wt %, above 10.8 wt %, above 11.1 wt %, above 11.6 wt %, above 12.0 wt % and even above 12.2 wt %. The inventor has surprisingly found that for some applications, even higher % Cr contents have a positive effect on mechanical properties. In different embodiments, % Cr is above 12.6 wt %, above 13.0 wt %, above 13.1 wt %, above 13.2 wt % and even above 13.3 wt % or more. For some applications, excessive % Cr seems to deteriorate the mechanical properties. In different embodiments, % Cr is below 13.0 wt %, below 12.9 wt %, below 12.4 wt %, below 12.2 wt % and even below 12.0 wt %. For some applications, lower % Cr contents are preferred. In different embodiments, % Cr is below 11.9 wt %, below 11.6 wt %, below 11.4 wt %, below 11.2 wt % and even below 10.9 wt % k. For some applications, higher % Ti contents have a positive effect on mechanical properties. In different embodiments, % Ti is above 0.6 wt %, above 0.9 wt %, above 1.1 wt %, above 1.5 wt % above 1.6 wt %, above 1.9 wt % and even above 2.1 wt %. On the other hand, for some applications, excessive % Ti seems to deteriorate the mechanical properties. In different embodiments, % Ti is below 2.1 wt %, below 1.9 wt %, below 1.5 wt %, below 1.3 wt %, below 1.0 wt %, below 0.98 wt % and even below 0.79 wt %. For some applications, higher % Al contents are preferred. In different embodiments, % Al is above 0.06 wt %, above 0.09 wt %, above 0.16 wt %, above 0.26 wt % above 0.39 wt % and even above 0.5 wt %. For some applications, even higher % Al contents are preferred. In different embodiments, % Al is above 0.68 wt %, above 0.86 wt %, above 1.1 wt %, above 1.16 wt % and even above 1.26 wt %. On the other hand, for some applications, excessive % Al seems to deteriorate the mechanical properties. In different embodiments, % Al is below 1.4 wt %, below 1.2 wt %, below 1.1 wt %, below 0.98 wt % and even below 0.8 wt %. For some applications, lower % Al contents are preferred. In different embodiments, % Al is below 0.6 wt %, below 0.5 wt %, below 0.49 wt %, below 0.24 wt % and even below 0.09 wt %. For some applications, the presence of % V is desirable, while in other applications it is rather an impurity. In different embodiments, % V is 0.0006 wt % or more, 0.01 wt % or more, 0.02 wt % or more, 0.1 wt % or more and even 0.16 wt % or more. For some applications, excessive % V seems to deteriorate the mechanical properties. In different embodiments, % V is below 0.34 wt %, below 0.24 wt %, below 0.14 wt %, below 0.09 wt % and even below 0.009 wt %. Obviously, there are cases where the desired nominal content is Owt % or nominal absence of the element as occurs with all optional elements for certain applications. For some applications, the presence of % Nb is desirable, while in other applications it is rather an impurity. In different embodiments, % Nb is above 0.001 wt %, above 0.006 wt %, above 0.06 wt %, above 0.16 wt % and even above 0.26 wt %. For some applications, excessive % Nb seems to deteriorate the mechanical properties. In different embodiments, % Nb is below 0.4 wt %, below 0.19 wt %, below 0.09 wt %, below 0.009 wt % and even below 0.0009 wt %. Obviously, there are cases where the desired nominal content is 0 wt % or nominal absence of the element as occurs with all optional elements for certain applications. For some applications, the presence of % Hf is desirable, while in other applications it is rather an impurity. In different embodiments. % Hf is above 0.008 wt %, above 0.09 wt %, above 0.16 wt % and even above 0.31 wt %. The inventor has found that for applications requiring high toughness levels, the % Hf and/or % Zr content should not be very high, as they tend to form big and polygonal primary carbides which act as stress raisers. In different embodiments, % Hf is below 0.69 wt %, below 0.39 wt %, below 0.14 wt %, below 0.09 wt % and even below 0.04 wt %. Obviously, there are cases where the desired nominal content is Owt % or nominal absence of the element as occurs with all optional elements for certain applications. For some applications, where the presence of strong carbide formers is advantageous, but where manufacturing cost is of importance the presence of % Zr is desirable. In different embodiments, % Zr is above 0.006 wt %, above 0.06 wt %, above 0.1 wt %, above 0.21 wt % and even above 0.36 wt %. For some applications, excessive % Zr seems to deteriorate the mechanical properties. In different embodiments, % Zr is below 0.58 wt %, below 0.38 wt %, below 0.13 wt %, below 0.08 wt % and even below 0.03 wt %. Obviously, there are cases where the desired nominal content is Owt % or nominal absence of the element as occurs with all optional elements for certain applications. For some applications, % Zr and/or % Hf can be partially or totally replaced by % Ta. In different embodiments, more than 25 wt % of the amount of % Hf and/or % Zr are replaced by % Ta, more than 50 wt % of the amount of % Hf and/or % Zr are replaced by % Ta and even more than 75 wt % of the amount of % Hf and/or % Zr are replaced by % Ta. In different embodiments, % Ta+% Zr is above 0.0009 wt %, above 0.09 wt %, above 0.1 wt % above 0.41 wt % and even above 0.61 wt %. For some applications, excessive % Ta+% Zr seems to deteriorate the mechanical properties. In different embodiments, % Ta+% Zr is below 0.9 wt %, below 0.28 wt %, below 0.14 wt % and even below 0.004 wt %. For some applications, when it comes to wear resistance the presence of % Hf and/or % Zr has a positive effect. If this is to be greatly increased, then other strong carbide formers like % Ta or even % Nb can also be used. In different embodiments, % Zr+% Hf+% Nb+% Ta is above 0.001 wt %, above 0.1 wt %, above 0.36 wt %, above 0.56 wt % and even above 1.1 wt %. For some applications, excessive/Zr+% Hf+% Nb+% Ta seems to deteriorate the mechanical properties. In different embodiments, % Zr+% Hf+% Nb+% Ta is below 0.9 wt %, below 0.44 wt %, below 0.29 wt % below 0.14 wt % and even below 0.001 wt %. For some applications, the presence of % P is desirable, while in other applications, it is rather an impurity. In different embodiments, % P is above 0.0001 wt %, above 0.001 wt %, above 0.008 wt % and even above 0.01 wt %. For some applications, excessive % P seems to deteriorate the mechanical properties. In different embodiments, % P is below 0.06 wt %, below 0.04 wt %, below 0.02 wt % and even below 0.002 wt %. Obviously, there are cases where the desired nominal content is Owt % or nominal absence of the element as occurs with all optional elements for certain applications. For some applications, the presence of % S is desirable, while in other applications, it is rather an impurity. In different embodiments, % S is above 0.0001 wt %, above 0.001 wt %, above 0.008 wt % and even above 0.01 wt %. For some applications, excessive % S seems to deteriorate the mechanical properties. In different embodiments, % S is below 0.07 wt %, below 0.05 wt %, below 0.04 wt %, below 0.03 wt %, below 0.01 wt % and even below 0.001 wt %. Obviously, there are cases where the desired nominal content is Owt % or nominal absence of the element as occurs with all optional elements for certain applications. For some applications, the presence of % Cu is desirable, while in other applications it is rather an impurity. In different embodiments, % Cu is above 0.0006 wt %, above 0.05 wt %, above 0.06 wt %, above 0.1 wt % and even above 0.16 wt %. For some applications, higher % Cu contents are preferred. In different embodiments, % Cu is 0.56 wt % or more, 0.91 wt % or more, 1.26 wt % or more, 1.81 wt % or more and even 2.16 wt % or more. For some applications, an excessive content is detrimental. In different embodiments, % Cu is below 3.4 wt %, below 2.9 wt %, below 2.4 wt %, below 1.9 wt %, below 1.4 wt % and even below 0.98 wt %. For some applications, lower % Cu contents are preferred. In different embodiments, % Cu is below 0.64 wt %, below 0.48 wt %, below 0.19 wt %, below 0.05 wt %, below 0.04 wt % and even below 0.001 wt %. Obviously, there are cases where the desired nominal content is Owt % or nominal absence of the element as occurs with all optional elements for certain applications. For some applications, the presence of % Pb is desirable, while in other applications it is rather an impurity. In different embodiments, % Pb is above 0.0006 wt %, above 0.09 wt %, above 0.12 wt %, above 0.16 wt % and even above 0.52 wt %. For some applications, excessive % Pb seems to deteriorate the mechanical properties. In different embodiments, % Pb is below 0.8 wt %, below 0.64 wt %, below 0.44 wt %, below 0.24 wt %, below 0.09 wt %, below 0.01 wt % and even below 0.004 wt %. Obviously, there are cases where the desired nominal content is Owt % or nominal absence of the element as occurs with all optional elements for certain applications. For some applications, the presence of % Bi is desirable, while in other applications it is rather an impurity. In different embodiments, % Bi is above 0.0001 wt %, above 0.001 wt %, above 0.009 wt %, above 0.01 wt % and even above 0.03 wt %. For some applications, excessive % Bi seems to deteriorate the mechanical properties. In different embodiments, % Bi is below 0.06 wt %, below 0.04 wt %, below 0.02 wt %, below 0.009 wt %, below 0.001 wt % and even below 0.0001 wt %. Obviously, there are cases where the desired nominal content is Owt % or nominal absence of the element as occurs with all optional elements for certain applications. For some applications, the presence of % Se is desirable, while in other applications it is rather an impurity. In different embodiments, % Se is above 0.0001 wt %, above 0.0009 wt %, above 0.001 wt %, above 0.009 wt %, above 0.01 wt % and even above 0.04 wt %. For some applications, excessive % Se seems to deteriorate the mechanical properties. In different embodiments, % Se is below 0.06 wt %, below 0.03 wt %, below 0.009 wt %, below 0.001 wt % and even below 0.0009 wt %. Obviously, there are cases where the desired nominal content is Owt % or nominal absence of the element as occurs with all optional elements for certain applications. For some applications, the presence of % Co is desirable, while in other applications it is rather an impurity. In different embodiments, % Co is above 0.0001 wt %, above 0.001 wt %, above 0.16 wt %, above 0.51 wt % and even above 0.81 wt %. For some applications, higher % Co contents are preferred. In different embodiments, % Co is above 1.1 wt %, above 1.6 wt %, above 1.8 wt %, above 2.1 wt % and even above 2.6 wt %. For some applications, excessive % Co seems to deteriorate the mechanical properties. In different embodiments, % Co is below 3.4 wt %, below 2.4 wt %, below 1.4 wt %, below 0.8 wt %, below 0.4 wt %, below 0.19 wt % and even below 0.02 wt %. Obviously, there are cases where the desired nominal content is Owt % or nominal absence of the element as occurs with all optional elements for certain applications. For some applications, higher % Mo contents are preferred. In different embodiments. % Mo is above 0.09 wt %, above 0.1 wt %, above 0.26 wt %, above 0.5 wt % and even above 0.51 wt %. For some applications, higher % Mo contents are preferred. In different embodiments, % Mo is above 0.66 wt %, above 0.81 wt %, above 1.1 wt and even above 1.5 wt %. For some applications, even higher levels are preferred. In different embodiments, % Mo is above 1.51 wt %, above 1.8 wt %, above 2.1 wt % and even above 2.3 wt %. For some applications, excessive % Mo seems to deteriorate the mechanical properties. In different embodiments, % Mo is below 2.4 wt %, below 1.94 wt %, below 1.5 wt %, below 1.19 wt %, below 0.9 wt % and even below 0.5 wt %. For some applications, lower % Mo contents are preferred. In different embodiments, % Mo is below 0.49 wt %, below 0.4 wt %, below 0.34 wt %, below 0.19 wt %, below 0.1 wt % and even below 0.09 wt %. For some applications, % Mo can be partially replaced with % W. This replacement takes place in terms of % Moeq. In different embodiments, the replacement of % Mo with % W is lower than 69 wt %, lower than 54 wt %, lower than 34 wt % and even lower than 12 wt %. For applications where thermal conductivity is to be maximized but thermal fatigue has to be regulated, it is normally preferred to have from 1.2 to 3 times more % Mo than % W, but not absence of % W. For some applications, higher % Moeq contents are preferred. In different embodiments, % Moeq is above 0.09 wt %, above 0.16 wt %, above 0.31 wt % and even above 0.5 wt %. For some applications, higher % Moeq contents are preferred. In different embodiments, % Moeq is above 0.51 wt %, above 0.81 wt %, above 1.1 wt %, above 1.3 wt % and even above 1.5 wt %. For some applications, even higher levels are preferred. In different embodiments, % Moeq is above 1.51 wt %, above 1.8 wt %, above 2.1 wt % and even above 2.3 wt %. For some applications, excessive % Moeq seems to deteriorate the mechanical properties. In different embodiments, % Moeq is below 2.4 wt %, below 1.9 wt %, below 1.5 wt % and even below 1.2 wt %. For some applications, lower % Moeq contents are preferred. In different embodiments, % Moeq is below 0.84 wt %, below 0.5 wt %, below 0.49 wt %, below 0.4 wt %, below 0.29 wt % and even below 0.09 wt %. For some applications, tungsten has also an effect on the deformation during heat treatment attainable. In different embodiments, % W is above 0.006 wt %, above 0.09 wt %, above 0.16 wt %, above 0.36 wt % and even above 0.4 wt %. For some applications, higher % W contents are preferred. In different embodiments, % W is above 0.66 wt %, above 1.1 wt %, above 1.6 wt %, above 1.86 wt %, above 2.1 wt % and even above 2.8 wt %. On the other hand, for some applications, excessive % W seems to deteriorate the mechanical properties. In different embodiments, % W is below 3.4 wt %, below 2.84 wt %, below 2.4 wt %, below 1.98 wt % and even below 1.49 wt %. Some applications benefit from a lower content of % W. In different embodiments, % W is below 0.98 wt %, below 0.4 wt %, below 0.09 wt % or even no intentional % W at all. Obviously, there are cases where the desired nominal content is 0 wt % or nominal absence of the element as occurs with all optional elements for certain applications. For some applications, the presence of % O is desirable, while in other applications it is rather an impurity. In different embodiments, % O is above 8 ppm, above 22 ppm, above 110 ppm, above 210 ppm, above 510 ppm and even above 1010 ppm. For some applications, excessive % O≤eems to deteriorate the mechanical properties. In different embodiments, % O is below 2990 ppm, below 1900 ppm, below 900 ppm and even below 490 ppm. Obviously, there are cases where the desired nominal content is 0 wt % or nominal absence of the element as occurs with all optional elements for certain applications. For some applications, the presence of % Y is desirable, while in other applications it is rather an impurity. In different embodiments, % Y is above 0.012 wt %, above 0.052 wt %, above 0.12 wt %, above 0.22 wt %, above 0.42 wt % and even above 0.82 wt %. For some applications, excessive % Y seems to deteriorate the mechanical properties. In different embodiments, % Y is below 0.74 wt %, below 0.48 wt %, below 0.34 wt %, below 0.18 wt % and even below 0.09 wt %. Obviously, there are cases where the desired nominal content is Owt % or nominal absence of the element as occurs with all optional elements for certain applications. For some applications, the presence of % Sc is desirable, while in other applications it is rather an impurity. In different embodiments, % Sc is above 0.012 wt %, above 0.052 wt %, above 0.12 wt %, above 0.22 wt %, above 0.42 wt % and even above 0.82 wt %. For some applications, excessive % Sc seems to deteriorate the mechanical properties. In different embodiments, % Sc is below 0.74 wt %, below 0.48 wt %, below 0.34 wt % and even below 0.18 wt %. Obviously, there are cases where the desired nominal content is 0 wt % or nominal absence of the element as occurs with all optional elements for certain applications. For some applications, a certain content of % Sc+% Y is desirable. In different embodiments, % Sc+% Y is above 0.012 wt %, above 0.052 wt %, above 0.12 wt %, above 0.22 wt %, above 0.42 wt % and even above 0.82 wt %. For some applications, excessive % Sc+% Y seems to deteriorate the mechanical properties. In different embodiments, % Sc+% Y is below 1.4 wt %, below 0.96 wt %, below 0.74 wt % and even below 0.48 wt %. For some applications, the presence of % REE (as previously defined) is desirable, while in other applications it is rather an impurity. In different embodiments, % REE is above 0.012 wt %, above 0.052 wt %, above 0.12 wt %, above 0.22 wt %, above 0.42 wt % and even above 0.82 wt %. For some applications, excessive % REE seems to deteriorate the mechanical properties. In different embodiments, % REE is below 1.4 wt %, below 0.96 wt %, below 0.74 wt % and even below 0.48 wt %. Obviously, there are cases where the desired nominal content is 0 wt % or nominal absence as occurs with all optional elements for certain applications. For some applications, a certain content of % Sc+% Y+% REE is desirable. In different embodiments, % Sc+% Y+% REE is above 0.012 wt %, above 0.052 wt %, above 0.12 wt %, above 0.22 wt %, above 0.42 wt % and even above 0.82 wt %. For some applications, excessive % Sc+% Y+% REE seems to deteriorate the mechanical properties. In different embodiments. % Sc+% Y+% REE is below 1.4 wt %, below 0.96, below 0.74 wt % and even below 0.48 wt %. For some applications, it has been found that the relation between % O and the sum of % Y+% Sc or alternatively % Y or alternatively % Y+% Sc+% REE has to be controlled for optimum mechanical properties of the final component (in this case percentages are atomic percentages). In an embodiment, KYO1*atm % O<atm % Y<KYO2*atm % O has to be met wherein atm % O means atomic percentage of oxygen and atm % Y means atomic percentage of yttrium. In another embodiment, KYO1*atm % O<atm % Y+atm % Sc<KYO2*atm % O. In another embodiment, KYO1*atm % O<atm % Y+atm % Sc+atm % REE<KYO2*atm % O, being % REE as previously defined. In different embodiments, KYO1 is 0.01, 0.1, 0.2, 0.4, 0.6 and even 0.7. In different embodiments, KYO2 is 0.5, 0.66, 0.75, 0.85, 1 and even 5. For some applications, % Y can be partially replaced with % Ti. In an embodiment, at least 12 wt % of % Y is replaced with % Ti. In another embodiment, at least 22 wt % of % Y is replaced with % Ti. In another embodiment, at least 42 wt % of % Y is replaced with % Ti. In another embodiment, at least 62 wt % of % Y is replaced with % Ti. In another embodiment, at least 82 wt % of % Y is replaced with % Ti. In a few applications, % Y can be totally replaced with % Ti. In an embodiment, % Y is replaced with % Ti. But most applications suffer from such total replacement. In an embodiment, no more than 92 wt % of % Y is replaced with % Ti. In another embodiment, no more than 82% of % Y is replaced with % Ti. In another embodiment, no more than 62 wt % of % Y is replaced with % Ti. In another embodiment, no more than 42 wt % of % Y is replaced with % Ti. Surprisingly enough, the controlled presence of % B seems to have a strong influence for some applications on the desirable level of % Mn+2*% Ni, some applications strongly benefiting from such presence and some on the contrary suffering from it. In different embodiments, when % B present in a quantity above 12 ppm, % Mn+2*% Ni is kept above 0.01 wt %, above 0.06 wt %, above 0.16 wt %, above 0.26 wt %, above 0.46 wt %, above 0.86 wt % and even above 1.56 wt %. As said, some applications (including some applications involving heat transference) do not benefit from the concurrent presence of high levels of % Mn+2*% Ni and % B. In different embodiments, when % B present in a quantity above 12 ppm, % Mn+2*% Ni is kept below 1.96 wt %, below 0.96 wt %, below 0.46 wt %, below 0.24 wt % and even below 0.09 wt %. All the upper and lower limits disclosed in the different embodiments can be combined among them in any combination, provided that they are not mutually exclusive. In an embodiment, the above disclosed composition refers to the composition of a single powder. In an alternative embodiment, the above disclosed composition refers to the mean composition of a powder mixture. For some applications, the “powder size critical measure” (as previously defined) is relevant and has a remarkable influence in the attainable properties of the final component. In different embodiments, the “powder size critical measure” (as previously defined) is 2 microns or larger, 22 microns or larger, 42 microns or larger, 52 microns or larger, 102 microns or larger and even 152 microns or larger. For some applications, excessively large size critical measures are difficult to deal especially for some fine detail geometries. In different embodiments, the “powder size critical measure” (as previously defined) is 1990 microns or smaller, 1490 microns or smaller, 990 microns or smaller, 490 microns or smaller, 290 microns or smaller, 190 microns or smaller and even 90 microns or smaller. The inventor has found that for some applications the manufacturing method for the powder has a remarkable influence in the attainable properties of the final component. In an embodiment, the powder is water atomized. In another embodiment, the powder comprises water atomized powder. In another embodiment, the powder is centrifugal atomized. In another embodiment, the powder comprises centrifugal atomized powder. In another embodiment, the powder is mechanically crushed. In another embodiment, the powder comprises crushed powder. In another embodiment, the powder is reduced. In another embodiment, the powder comprises reduced powder. In another embodiment, the powder is gas atomized. In another embodiment, the powder comprises gas atomized powder.

For some applications, the above disclosed composition can be advantageously used in a method for additively manufacturing a component, wherein successive layers of materials are provided on each other to build-up, layer-by-layer, the three-dimensional component. An embodiment is directed to a method for additively manufacturing a metallic component comprising: providing an iron based alloy in powder form comprising: % Mo: 0.05-2.9; % W: 0-3.9; % Moeq: 0.05-2.9; % Ceq: 0.002-0.14; % C: 0.002-0.09: % N: 0-2.0; % B: 0-0.08; % Si: 0.05-1.5; % Mn: 0.05-1.5; % Ni: 9.5-11.9; % Cr: 10.5-13.5; % Ti: 0.5-2.4;% Al: 0.001-1.5;% V: 0-0.4; % Nb: 0-0.9; % Zr: 0-0.9; % Hf: 0-0.9; % Ta: 0-0.9;% S: 0-0.08;% P: 0-0.08; % Pb: 0-0.9; % Cu: 0-3.9; % Bi: 0-0.08; % Se: 0-0.08; % Co: 0-3.9; % REE: 0-1.4; % Y: 0-0.96; % Sc: 0-0.96; % Cs: 0-1.4; % O: 0-0.299% Y+% Sc+% REE: 0.006-1.9%; the rest consisting of iron and trace elements; wherein all percentages are indicated in weight percent: wherein % Ceq=% C+0.86*% N+1.2*% B and % Moeq=% Mo+% h*% W; and wherein % REE is as previously defined: and forming at least one layer of the alloy, by melting the iron based alloy into a molten state and cooling and forming a solidified layer of the iron based alloy. Different technologies can be used to manufacture the component. Non-limiting examples of AM technologies that can be employed are: direct metal laser melting (DMLS), selective laser melting (SLM), electron beam melting (EBM), selective laser sintering (SLS), direct energy deposition (DeD), big area additive manufacturing (BAAM), Joule printing, and/or combinations thereof. In an embodiment, the AM method is SLS. In another embodiment, the AM method is SLM. In another embodiment, the AM method is DoD. In another embodiment, the AM method is EBM. In another embodiment, the AM method is BAAM. In another embodiment, the AM method is Joule printing. In another embodiment, the AM method is DMLS. For certain applications, the use of at least two different AM technologies may be advantageous. Another embodiment is directed to a method for additively manufacturing a metallic component comprising: providing an iron based alloy in powder form comprising: % Mo: 0.05-2.9; % W: 0-3.9; % Moeq: 0.05-2.9; % Ceq: 0.002-0.14: % C: 0.002-0.09: % N: 0-2.0; % B: 0-0.08: % Si: 0.05-1.5; % Mn: 0.05-1.5; % Ni: 9.5-11.9; % Cr: 10.5-13.5; % Ti: 0.5-2.4: % Al: 0.001-1.5:% V: 0-0.4:% Nb: 0-0.9;% Zr: 0-0.9:% Hf: 0-0.9;% Ta: 0-0.9;% S: 0-0.08;% P: 0-0.08: % Pb: 0-0.9:% Cu: 0-3.9; % Bi: 0-0.08; % Se: 0-0.08; % Co: 0-3.9; % REE: 0-1.4; % Y: 0-0.96; % Sc: 0-0.96; % Cs: 0-1.4: % O: 0-0.299% Y+% Sc+% REE: 0.006-1.9%: the rest consisting of iron and trace elements: wherein all percentages are indicated in weight percent: wherein % Ceq-% C+0.86*% N+1.2*% B and % Moeq-% Mo+½*% W; and % REE is as previously defined and an organic material; and build-up, layer-by-layer, a three-dimensional component. Non-limiting examples of AM technologies that can be employed are: fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), selective laser sintering (SLS), selective heat sintering (SHS), direct energy deposition (DeD), big area additive manufacturing (BAAM) and/or combinations thereof. In an embodiment, the AM method is SLS. In another embodiment, the AM method is SHS. In another embodiment, the AM method is DLS. In another embodiment, the AM method is a technology based on CLIP. In another embodiment, the AM method is a DLS based on CLIP. In another embodiment, the AM method is MJF. In another embodiment, the AM method is BJ. In another embodiment, the AM method is DOD. In another embodiment, the AM method is SLA. In another embodiment, the AM method applied in the forming step is DLP. In another embodiment, the AM method is CDLP. In another embodiment, the AM method is FDM. In another embodiment, the AM method is a FDM method where the filament or wire employed comprises a mixture of an organic material and a powder or powder mixture. In another embodiment, the AM method is FFF. In another embodiment, the AM method is a FFF method where the filament or wire employed comprises a mixture of an organic material and a powder or powder mixture. In another embodiment, the AM method is DeD. In another embodiment, the AM method is DeD where the melting source is a laser. In another embodiment, the AM technology is DeD where the melting source is an electron beam. In another embodiment, the AM method is DeD where the melting source is an electric arc. In another embodiment, the AM method is BAAM. For certain applications, the use of at least two different AM technologies may be advantageous. Alternatively, the above disclosed composition can be used in a manufacturing method comprising the use of a mold having the desired form of the component to be manufactured and filed with the iron based alloy in powdered form. The additively manufactured component obtained after applying the AM step or the molding step can be subjected to any of the treatments disclosed throughout in this document including, but not limited to, a debinding step, a fixing step, a pressure and/or temperature treatment, a consolidation step, a densification step, a heat treatment, a machining and/or a surface conditioning, among others. Another embodiment is directed to an additively manufactured component comprising at least one iron based alloy layer comprising: % Mo: 0.05-2.9; % W: 0-3.9; % Moeq: 0.05-2.9; % Ceq: 0.002-0.14; % C: 0.002-0.09; % N: 0-2.0; % B: 0-0.08; % Si: 0.05-1.5; % Mn: 0.05-1.5; % Ni: 9.5-11.9; % Cr: 10.5-13.5; % Ti: 0.5-2.4; % Al: 0.001-1.5; % V: 0-0.4; % Nb: 0-0.9; % Zr: 0-0.9; % Hf: 0-0.9; % Ta: 0-0.9;% S: 0-0.08; % P: 0-0.08; % Pb: 0-0.9;% Cu: 0-3.9; % Bi: 0-0.08;% Se: 0-0.08;% Co: 0-3.9:% REE: 0-1.4; % Y: 0-0.96; % Sc: 0-0.96; % Cs: 0-1.4; % O: 0-0.299% Y+% Sc+% REE: 0.006-1.9%; the rest consisting of iron and trace elements: wherein all percentages are indicated in weight percent: wherein % Ceq=% C+0.86% N+1.2*% B, and % Moeq=% Mo+½*% W and % REE is the sum of actinides and lanthanides. In an embodiment, the manufactured component is a piece. In another embodiment, the manufactured component is a mold. In another embodiment, the manufactured component is a die. In another embodiment, the manufactured component is a plastic injection mold. In another embodiment, the manufactured component is a plastic injection die. In another embodiment, the manufactured component is a die casting die. In another embodiment, the manufactured component is a light alloy die casting die. In another embodiment, the manufactured component is an aluminium die casting die. In another embodiment, the manufactured component is a drawing die. In another embodiment, the manufactured component is a bending die. In another embodiment, the manufactured component is a cutting die. In an embodiment, the method disclosed above is used to manufacture at least part of a component. On the other hand, in some embodiments, it is advantageous to manufacture the entire component using the method disclosed above. For certain applications, it is advantageous to manufacture the component (or at least the part of the component manufactured using the method disclosed above) using different materials. In an embodiment, the manufactured component comprises at least two different materials. In another embodiment, the manufactured component comprises at least three different materials. In another embodiment, the manufactured component comprises at least four different materials. All the embodiments disclosed above can be combined among them in any combination, provided that they are not mutually exclusive, for example: a powder for use in additive manufacturing having the following composition, all percentages being indicated in weight percent: % Mo: 0.05-2.9; % W: 0-3.9; % Moeq: 0.05-2.9; % Ceq: 0.002-0.14: % C: 0.002-0.09: % N: 0-2.0: % B: 0-0.08; % Si: 0.05-1.5; % Mn: 0.05-1.5; % Ni: 9.5-11.9; % Cr: 10.5-13.5: % Ti: 0.5-2.4: % Al: 0.001-1.5; % V: 0-0.4; % Nb: 0-0.9; % Zr: 0-0.9; % Hf: 0-0.9; % Ta: 0-0.9; % S: 0-0.08: % P: 0-0.08: % Pb: 0-0.9; % Cu: 0-3.9; % Bi: 0-0.08: % Se: 0-0.08: % Co: 0-3.9; % REE: 0-1.4: % Y: 0-0.96: % Sc: 0-0.96; % Cs: 0-1.4: % O: 0-0.299% Y+% Sc+% REE: 0.006-1.9% the rest consisting of iron and trace elements, wherein % Ceq=% C+0.86*% N+1.2*% B: and % Moeq=% Mo+h*% W; wherein % REE is as previously defined; wherein the sum of all trace elements is below 2.0 wt %; or for example: a method for additively manufacturing a component, comprising: providing a powder mixture having the following mean composition, all percentages being indicated in weight percent: % Mo: 0.05-2.9; % W: 0-3.9; % Moeq: 0.05-2.9; % Ceq: 0.002-0.14; % C: 0.002-0.09; % N: 0-2.0; % B: 0-0.08; % Si: 0.05-1.5; % Mn: 0.05-1.5; % Ni: 9.5-11.9; % Cr: 10.5-13.5; % Ti: 0.5-2.4;% Al: 0.001-1.5; % V: 0-0.4; % Nb: 0-0.9; % Zr: 0-0.9; % Hf: 0-0.9; % Ta: 0-0.9; % S: 0-0.08; % P: 0-0.08; % Pb: 0-0.9; % Cu: 0-3.9; % Bi: 0-0.08; % Se: 0-0.08; % Co: 0-3.9; % REE: 0-1.4; % Y: 0-0.96; % Sc: 0-0.96; % Cs: 0-1.4; % O: 0-0.299% Y+% Sc+% REE: 0.006-1.9% the rest consisting of iron and trace elements, wherein % Ceq=% C+0.86*% N+1.2*% B; and % Moeq-% Mo+½*% W; wherein % REE is as previously defined; and wherein the sum of all trace elements is below 1.4 wt %, and forming at least one layer of the alloy, by melting the iron based alloy into a molten state and cooling and forming a solidified layer of the iron based alloy, wherein the AM method is selected from DeD, BAAM, SLS, SLM, DMLS, Joule Printing and EBM, wherein the additively manufactured component is subjected at least to a pressure and/or temperature treatment, a consolidation step, a densification step and/or a heat treatment (being such treatments, for example, as described in this document).

For some applications, especially when involving highly alloyed powders or powder mixtures, achieving the expected high performance can be quite challenging. As has been described in this document, several strategies have been developed to overcome this difficulty which unless otherwise specified can be used additively. One more such strategy consists in employing a high pressure, high temperature cycle where the pressure is strongly variated during the cycle presenting at least two high pressure periods in two different moments in time. Unless otherwise stated, the feature “high pressure, high temperature cycle where the pressure is strongly variated during the cycle presenting at least two high pressure periods in two different moments in time” is defined throughout the present document in the form of different alternatives, that are explained in detail below. Since such method has not been found by the inventor in the open literature, a method is claimed where a component with a determined apparent density is subjected to a treatment comprising the following steps:
Step 1: a high pressure and high temperature treatment,
Step 2: a moderate pressure high temperature treatment and
Step 3: a high pressure and high temperature treatment.

One would normally expect steps 2 and especially step 3 to be redundant and contribute little to the properties of the treated component, but for some materials the method described brings along exceptional improvement in the mechanical properties. In an embodiment, all three steps are made in the same furnace. In an embodiment, all three steps are made in the same furnace including a lowering of the pressure while at high temperature. In an embodiment, at least two of the steps are made in the same furnace including a significant change of pressure while at high temperature. It has been observed with no excessive surprise that low apparent densities when starting this treatment often lead to unsatisfactory mechanical performance, but in fact lower apparent densities that foreseeable can be treated successfully with this method for some applications and that came more unexpected. In different embodiments, the determined apparent density of the component to be subjected to a treatment according to the present method has to be selected to be 32% or higher, 52% or higher, 66% or higher, 71% or higher, 75% or higher and even 81% or higher. With far more surprise it has been observed that excessive determined apparent density leads to undesirable results as well, both in performance and economic terms. In different embodiments, the determined apparent density of the component to be subjected to a treatment according to the present method has to be selected to be 99.4% or lower, 96% or lower, 94% or lower, 88% or lower, 84% or lower and even 78% or lower. In this context, the determined apparent density=[real density/theoretical density]*100). In an embodiment, the real density of the component is measured by the Archimedes' Principe. In an alternative embodiment, the real density of the component is measured by the Archimedes' Principe according to ASTM B962-08. In an embodiment, the densities are at 20° C. and 1 atm. All the embodiments disclosed above can be combined among them in any combination, provided that they are not mutually exclusive. Also, as expected, the selected pressure has incidence on the final attained properties and thus the right level of pressure has to be selected. In different embodiments, a high pressure means 22 MPa or more, 52 MPa or more, 72 MPa or more, 102 MPa or more, 202 MPa or more and even 402 MPa or more. For some applications, excessively high pressures should be avoided. In different embodiments, a high pressure means 1900 MPa or loss, 890 MPa or less, 390 MPa or less, 290 MPa or less and even 190 MPa or less. All the embodiments disclosed above can be combined among them in any combination, provided that they are not mutually exclusive, for example: in an embodiment, the high pressure is between 22 MPa and 1900 MPa. For some applications, excessive moderate pressures should be avoided. In different embodiments, a moderate pressure means 90 MPa or less, 19 MPa or less, 9 MPa or loss, 0.9 MPa or less, 1900 mbar or loss, 900 mbar or less and even 90 mbar or less. There are also applications where too low a moderate pressure is also not preferable. In different embodiments, a moderate pressure means 1e⁻⁹ mbar or more, 1e⁻⁵ mbar or more, 0.01 mbar or more, 10 mbar or more, 600 mbar or more, 1200 mbar or more and even 250 bar or more. All the embodiments disclosed above can be combined among them in any combination, provided that they are not mutually exclusive, for example: in an embodiment, the moderate pressure is between 1e⁻¹² bar and 90 MPa. When performing more than one step in the same oven or furnace and even more when doing so without strongly reducing the temperature in between, the significant change of pressure applied has to be properly controlled. In different embodiments, a significant change of pressure means 0.2 MPa or more, 52 MPa or more, 82 MPa or more, 102 MPa or more, 202 MPa or more and even 402 MPa or more. For some applications, excessive significant change of pressure is not advisable. In different embodiments, a significant change of pressure means 890 MPa or less, 380 MPa or less, 290 MPa or less and even 190 MPa or less. All the embodiments disclosed above can be combined in any combination among them, provided they are not mutually exclusive, for example: in an embodiment, the significant change of pressure is between 0.2 MPa and 890 MPa. For some applications, it is better to define what a high temperature treatment means in the present method in terms of the critical melting temperature (Tcm). In different embodiments, a high temperature means 0.36*Tcm or more, 0.46*Tcm or more, 0.52*Tcm or more, 0.66*Tcm or more, 0.76*Tcm or more and even 0.82*Tcm or more, being Tcm the melting temperature of the powder with the lowest melting point in the powder mixture. For some applications, excessively high temperatures should be avoided. In an embodiment, a high temperature means 2.9*Tcm or less, 1.9° Tcm or less, 0.99*Tcm or less, 0.89*Tcm or less and even 0.79*Tcm or less, being Tcm the melting temperature of the powder with the lowest melting point in the powder mixture. In this document, unless otherwise indicated, the melting temperature refers to the temperature at which the first liquid forms under equilibrium conditions. In an alternative embodiment, Tcm is the melting temperature of the metallic powder with the lowest melting point in the powder mixture which is a critical powder (as previously defined). In another alternative embodiment, Tcm is the melting temperature of the metallic powder with the lowest melting point in the powder mixture which is a relevant powder (as previously defined). In another alternative embodiment, Tcm is the mean melting temperature of the metal comprising powder mixture (volume-weighted arithmetic mean, where the weights are the volume fractions). In another alternative embodiment. Tom refers to the melting temperature of a powder mixture (as previously defined). In some embodiments, when only one metallic powder is used. Tcm is the melting temperature of the metallic powder. In this context, the temperatures disclosed above are in kelvin. In an embodiment, the melting temperature is measured according to ASTM E794-06(2012) Standard test method for melting and crystallization temperatures by thermal analysis. In an embodiment, the melting temperature is measured by differential scanning calorimetry (DSC). In an alternative embodiment, the melting temperature is measured by differential thermal analysis (DTA). All the embodiments disclosed above can be combined among them in any combination, provided that they are not mutually exclusive, for example: in an embodiment, Tcm is the melting temperature of the powder with the lowest melting point which is at least 0.06 wt % of the powder mixture. For some applications, it is better to define what a high temperature treatment means in absolute terms. In different embodiments, a high temperature means 255° C. or more, 555° C. or more, 855° C. or more, 955° C. or more, 1055° C. or more, 1155° C. or more, 1255° C. or more and even 1455° C. or more. For some applications, excessively high temperatures should be avoided. In different embodiments, a high temperature means 3900° C. or less, 2900° C. or less, 2400° C. or less, 1900° C. or less, 1490° C. or less, 1290° C. or less, 1190° C. or less and even 900° C. or less. All the embodiments disclosed above can be combined among them in any combination, provided that they are not mutually exclusive, for example: in an embodiment, a high temperature is a temperature between 255° C. and 3900° C. For some applications, the dwell time in which the temperature is kept within the high temperature range is important. In different embodiments, the dwell time in which the temperature is kept within the high temperature range is 0.1 h or more, 0.52 h or more, 1.02 h or more, 2.52 h or more, 5.52 h or more, 15.2 h or more and even 152 h or more. For some applications, an excessively long dwell time is not recommendable. In different embodiments, the dwell time in which the temperature is kept within the high temperature range is 1900 h or less, 192 h or less, 42 h or less, 19 h or less, 4 h or less and even 0.9 h or less. All the embodiments disclosed above can be combined in any combination, provided that they are not mutually exclusive, for example: in an embodiment, the dwell time in which the temperature is kept within the high temperature range is between 0.1 h and 1900 h. For some applications, the dwell time in which the pressure is kept within the high pressure range is important. In different embodiments, the dwell time in which the pressure is kept within the high pressure range is 0.01 h or more, 0.12 h or more, 0.52 h or more, 1.02 h or more, 2.52 h or more, 5.22 h or more, 15.2 h or more and even 142 h or more. For some applications, an excessively long dwell time is not recommendable. In different embodiments, the dwell time in which the pressure is kept within the high pressure range is 1700 h or loss, 182 h or less, 42 h or less, 19 h or less, 4 h or loss, 0.9 h or loss. All the embodiments disclosed above can be combined among them in any combination, provided that they are not mutually exclusive, for example: in an embodiment, the dwell time in which the pressure is kept within the high pressure range is between 0.01 h and 1700 h. For some applications, the dwell time in which the pressure is kept within the moderate pressure range is important. In different embodiments, the dwell time in which the pressure is kept within the moderate pressure range is 0.01 h or more, 0.12 h or more, 0.52 h or more, 1.02 h or more, 2.52 h or more, 5.22 h or more, 15.2 h or more and even 142 h or more. For some applications, an excessively long dwell time is not recommendable. In different embodiments, the dwell time in which the pressure is kept within the moderate pressure range is 1800 h or less, 172 h or less, 42 h or less, 19 h or less, 4 h or less and even 0.8 h or less. The embodiments disclosed above can be combined among them in any combination, provided that they are not mutually exclusive, for example: in an embodiment, the dwell time in which the pressure is kept within the moderate pressure range is between 0.01 h and 1800 h. All the embodiments disclosed above can be combined among them and with any other embodiment disclosed in this document in any combination, provided that they are not mutually exclusive. Some combinations of embodiments are for example: a method where a component with an apparent density between 32% and 99.4% is subjected to a treatment comprising the following steps: step 1: applying a treatment at a high pressure between 22 MPa and 1900 MPa, and a high temperature between 255° C. and 3900° C.; step 2: applying a treatment at a moderate pressure between 1e⁻¹² bar and 90 MPa, and a high temperature between 255° C. and 3900° C.; step 3: applying a treatment at a high pressure between 22 MPa and 1900 MPa, and a high temperature between 255° C. and 3900° C.; wherein the dwell time in which the temperature is kept within the high temperature range is between 0.1 h and 1900 h: and wherein the dwell time in which the pressure is kept within the moderate pressure range is 0.01 h or more and 1700 h or less; or for example: a method where a component manufactured using a powder mixture which comprises internal porosities is subjected to a treatment comprising the following steps: step 1: applying a treatment at a high pressure between 22 MPa and 1900 MPa, and a high temperature between 0.36*Tcm and 2.9*Tcm; step 2: applying a treatment at a moderate pressure between 1e² bar and 90 MPa, and a high temperature between 0.36*Tcm and 2.9*Tcm: step 3: applying a treatment at a high pressure between 22 MPa and 1900 MPa, and a high temperature between 0.36*Tcm and 2.9*Tcm: wherein Tcm is the melting temperature of the powder with the lowest melting point in the powder mixture used to manufacture the component: wherein the dwell time in which the pressure is kept within the high pressure range is between 0.1 h and 1900 h; and wherein the dwell time in which the pressure is kept within the moderate pressure range is between 0.01 h and 1700 h. All the embodiments disclosed above can be combined among them and with any other embodiment disclosed in this document that relates to the application of a “high pressure, high temperature cycle where the pressure is strongly variated during the cycle presenting at least two high pressure periods in two different moments in time” in any combination, provided that they are not mutually exclusive.

From the alloying concepts relying on a heat treatment to achieve the desirable properties, some alloying concepts require fast cooling to achieve the preferred properties while others on the contrary can only achieve the desirable properties when slowly cooled. Fast cooling often brings along other undesirable side effects on the side of cost associated to cracking, shape retention, inhomogeneous properties, etc. The inventor has found with surprise that some alloying concepts can achieve very desirable properties through fast cooling without the mentioned negative side effects or at least with a very small incidence on both cost and performance. For some applications, a heat treatment comprising a fast enough cooling can be advantageously applied in combination with the “proper geometrical design strategy” previously defined in this document. In an embodiment, the “proper geometrical design strategies” previously defined in this document are employed in a material comprising at least one of the alloying strategies laid up in this document and a heat treatment comprising a fast enough cooling as detailed below. It has been found that for some applications how the fast enough cooling is implemented has an incidence on the attained properties. Unless otherwise stated, the feature “fast enough cooling” is defined throughout the present document in the form of different alternatives, that are explained in detail below. In an embodiment, the fast enough cooling is implemented by convection with a colder fluid. In an embodiment, the colder fluid comprises a gas. In an embodiment, the colder fluid is mainly (more than 50 vol %) a gas. In an embodiment, the colder fluid comprises a liquid. In an embodiment, the colder fluid is mainly (more than 50 vol %) a liquid. In an embodiment, the colder fluid comprises Ar. In an embodiment, the colder fluid comprises He. In an embodiment, the colder fluid comprises nitrogen. In an embodiment, the colder fluid comprises hydrogen. In an embodiment, the colder fluid comprises a molten salt. In an embodiment, the colder fluid comprises water. In an embodiment, the colder fluid comprises water vapor. In an embodiment, the colder fluid comprises methane. In an embodiment, the colder fluid comprises an organic component. In an embodiment, the colder fluid is at least partially replaced by a fluidized bed of solid particles. In different embodiments, a colder fluid is one that has a mean temperature at least 55° C. lower, at least 155° C. lower, at least 355° C. lower, at least 555° C. lower and even at least 1055° C. lower than the maximum temperature achieved by the component being heat treated. For some applications, excessive high temperature is not recommendable. In different embodiments, a colder fluid is one that has a mean temperature at most 3555° C. lower, at most 2555° C. lower and even at most 1555° C. lower than the maximum temperature achieved by the component being heat treated. In several applications, it has been found that the pressure at which the fluid is being kept plays a surprisingly important role in attaining the properties sought for at a reasonable cost. In different embodiments, the colder fluid is pressurized to 2.1 bar or more, to 6.1 bar or more, to 11 bar or more, to 21 bar or more and even to 31 bar or more. For some applications, excessive pressure is not recommendable. In different embodiments, the colder fluid is pressurized to less than 98 bar and even to less than 48 bar. For some applications, it has been found that even much higher pressures bring an advantage. In different embodiments, the colder fluid is pressurized to 120 bar or more, to 520 bar or more, to 1100 bar or more, to 1550 bar or more, to 2100 bar or more and even to 6000 bar or more. Excessive pressure seems to not be advantageous any more. In different embodiments, the colder fluid is pressurized to less than 22000 bar, to less than 12000 bar, to less than 4000 bar and even to less than 1900 bar. In an embodiment, pressurized refers to the maximum pressure of the fluid inside the chamber where the cooling of the component takes place. In an embodiment, pressurized refers to the mean maximum pressure of the fluid inside the chamber where the cooling of the component takes place. In different embodiments, the mean is calculated for the 2 minutes, for the 5 minutes and even for the 15 minutes where the pressure is highest. It has been found that for some applications the most convenient way to quantify the fast enough cooling to be imposed is through the cooling rate. In different embodiments, the cooling rate is 1.2 K/min or higher, 1.2 K/s or higher, 22 K/s or higher, 52 K/s or higher, 102 K/s or higher, 202 K/s or higher, 302 K/s or higher and even 502 K/s or higher. Some applications do not benefit from an excessive cooling rate. In different embodiments, the cooling rate is 1020 K's or lower, 490 K/s or lower, 190 K/s or lower, 90 K/s or lower and even 38 K/s or lower. In an embodiment, the cooling rate refers to the maximum cooling rate throughout the process. In an alternative embodiment, the cooling rate of the component is the maximum value of cooling rate simulated in the whole process. In another alternative embodiment, the cooling rate of the component is the mean value of the cooling rate. In an embodiment, the mean value of the cooling rate is calculated in the interval where the maximum temperature of the component is between 700° C. and 400° C. In another embodiment, the mean value of the cooling rate is calculated in the interval where the maximum temperature of the component is between 5600° C. and 500° C. All the embodiments disclosed above can be combined among them in any combination, provided that they are not mutually exclusive, for example: a heat treatment comprising a fast cooling rate between 1.2 K/min and 1020 K/sec, wherein the cooling is made with a colder fluid which comprises more than 50 vol % of a gas, which is pressurized from 2.1 bar or more to less than 22000 bar; or for example: a heat treatment comprising a fast cooling rate between 1.2 K/min and 1020 K/sec, wherein the cooling is made by convection with a colder fluid which comprises a gas: It has been found that for some applications the most convenient way to quantify the fast enough cooling to be imposed is through the heat transference coefficient at the interface component—colder fluid. In different embodiments, the heat transference coefficient at the colder fluid-component interface is 2.5 W/(m²*K) or more, 25 W/(m²*K) or more, 250 W/(m²*K) or more, 1005 W/(m²*K) or more, 2500 W/(m²*K) or more and even 5200 W/(m²*K) or more. For some applications, excessive heat transference brings along shortcomings both from the performance and cost side. In different embodiments, the heat transference coefficient at the colder fluid-component interface is 24000 W/(m²*K) or less, 14000 W/(m²*K) or less, 4900 W/(m²*K) or less and even 900 W/(m²*K) or less. In an embodiment, the heat transference coefficient at the colder fluid-component interface is the maximum value of heat transference coefficient measured in the whole process. In an alternative embodiment, the heat transference coefficient at the colder fluid-component interface is the maximum value of heat transference coefficient simulated in the whole process. In another alternative embodiment, the heat transference coefficient at the colder fluid-component interface is the mean value of heat transference coefficient. In an embodiment, the mean value of the heat transference coefficient is calculated in the interval where the maximum temperature of the component is between 700° C. and 400° C. In another embodiment, the mean value of the heat transference coefficient is calculated in the interval where the maximum temperature of the component is between 560° C. and 500° C. In an embodiment, the heat transference coefficient at the colder fluid-component interface is the maximum theoretical value of heat transference coefficient. In an embodiment, the simulation of the heat transference coefficient is done by means of finite element simulation (FEM) and artificial neural network (ANN) [as done in Prediction of heat transfer coefficient during quenching of large size forged blocks using modeling and experimental validation—by Yassine Bouissa et al.]. All the embodiments disclosed above can be combined among them and with any other embodiment disclosed in this document that relates to a “fast enough cooling” in any combination, provided that they are not mutually exclusive.

The invention disclosed in the following paragraphs relates to a method for producing metal-comprising geometrically complex pieces and/or parts (components). The method is particularly indicated to manufacture highly performant components. The method is also indicated for very large components. For some applications, the method comprises: applying an additive manufacturing (AM) method to form the component. For some applications, the AM method comprises the use of an organic material binder. In an embodiment, the method comprises the use of a MAM technology. For some applications, other cold manufacturing methods including extrusion and/or metal injection molding (MIM) can also be applied. For some applications, the use of extrusion to manufacture a polymeric filament or wire comprising metallic particles is particularly interesting. In an embodiment, the method comprises the use of fused deposition (FDM). In an embodiment, the method comprises the use of fused filament fabrication (FFF). In an embodiment, the metallic particles comprise any of the powders and/or powder mixtures disclosed throughout this document. In an embodiment, the method comprises the use of any of the powders and/or powder mixtures disclosed in this document to manufacture a component. In an embodiment, the powder or powder mixture comprises a nitrogen austenitic steel powder. In an embodiment, the powder mixture comprises at least one nitrogen austenitic steel powder. For certain applications, the use of a nitrogen austenitic steel powder or a powder mixture having an overall composition corresponding to that of a nitrogen austenitic steel is preferred. In an embodiment, the powder is a nitrogen austenitic steel powder. In an embodiment, the powder mixture has a mean composition corresponding to that of a nitrogen austenitic steel. In some embodiments, the use of powder or powder mixtures according to the mixing strategies previously defined in this document. Accordingly, all the embodiments related to the powders or powders mixtures disclosed in the mixing strategies can be combined with the present method in any combination. In an embodiment, the powder mixture comprises at least a LP and SP powder (as previously defined). In an embodiment, the powder or powder mixture comprises a LP powder (as previously defined). In an embodiment, the powder or powder mixture comprises a SP powder (as previously defined). In an embodiment, the powder or powder mixture comprises at least a powder P1, P2, P3 and/or P4 (as previously defined). In some embodiments, it is particularly interesting the use of the powders and/or powder mixtures disclosed in patent application number PCT/EP2019/075743, the contents of which are incorporated herein by reference. In an embodiment, the method comprises the use of a powder mixture comprising at least one metal powder to manufacture a component. In an embodiment, the method comprises a step wherein at least part of a component is manufactured by AM. In an embodiment, the method comprises a step wherein a component is manufactured by AM. In an embodiment, the method comprises a step wherein at least part of a component is manufactured by MAM. In an embodiment, the method comprises a step wherein a component is manufactured by MAM. In an embodiment, the method comprises the use of an organic material. In an embodiment, the method comprises a step wherein at least part of a component is manufactured by an AM method which comprises the use of an organic material. In an embodiment, the method comprises a step wherein a component is manufactured by an AM method which comprises the use of an organic material. In an embodiment, the organic material comprises a binder. In an embodiment, the organic material is a binder. In an embodiment, the organic material comprises a glue. In an embodiment, the organic material is a glue. In an embodiment, the organic material comprises a polymeric material. In an embodiment, the organic material is a polymeric material. In an embodiment, the organic material comprises a polymer. In an embodiment, the organic material is a polymer. In an embodiment, the method comprises a step wherein at least part of a component is manufactured by binder jetting (BJ, also called jet binding or binder jet 3D printing). In an embodiment, the method comprises a step wherein a component is manufactured by binder jetting (BJ). In an embodiment, the method comprises a step wherein at least part of a component is manufactured by fused deposition (FDM). In an embodiment, the method comprises a step wherein a component is manufactured by fused deposition (FDM). In an embodiment, the method comprises a step wherein at least part of a component is manufactured by fused filament fabrication (FFF). In an embodiment, the method comprises a step wherein a component is manufactured by fused filament fabrication (FFF). In an embodiment, the method comprises a step wherein at least part of a component is manufactured by extrusion. In an embodiment, the method comprises a step wherein a component is manufactured by material extrusion. In an embodiment, the extruded material is a filament or wire. In an embodiment, the method comprises a step wherein at least part of a component is manufactured by MIM. In an embodiment, the method comprises a step wherein a component is manufactured by MIM.

For some applications, the manufactured component is then subjected to a treatment comprising the application of pressure. In an embodiment, the method further comprises a step wherein the manufactured component is subjected to a pressure and/or temperature treatment.

For some applications, a minimum processing time is required. In different embodiments, the pressure and/or temperature treatment processing time is at least 1 min, at least 6 min, at least 25 min, at least 246 min, at least 410 min and even at least 1200 min. For some applications, excessive processing times seem to deteriorate the mechanical properties of the manufactured component. In different embodiments, the pressure and/or temperature treatment processing time is less than 119 hours, less than 47 hours, less than 23.9 hours, less than 12 hours, less than 2 hours, less than 54 minutes, less than 34 minutes, less than 24.9 minutes, less than 21 minutes, less than 14 minutes and even less than 8 minutes.

For some applications, it is important which means are used to apply the pressure. On the other hand, some applications are rather insensitive as how pressure is applied and even the pressure level attained. In this regard, the inventor has found that some applications benefit from the application of the pressure in a homogeneous way. In an embodiment the pressure and/or temperature treatment comprises applying the “strategies developed for the application of pressure in a homogeneous way” (as previously defined). The inventor has also found that for some applications, it is particularly advantageous to perform at least part of the heating using microwaves. In an embodiment, the pressure and/or temperature treatment comprises applying a “microwave heating” (as previously defined).

In some embodiments, the pressure employed in the pressure and/or temperature treatment may be relevant to the mechanical properties of the manufactured component. In different embodiments, the pressure applied in the pressure and/or temperature treatment is 6 MPa or more, 60 MPa or more, 110 MPa or more, 220 MPa or more, 340 MPa or more, 560 MPa or more, 860 MPa or more and even 1060 MPa or more. For some applications, the application of excessive pressure seems to deteriorate the mechanical properties of the manufactured component. In different embodiments, the pressure applied in the pressure and/or temperature treatment is 2100 MPa or less, 1600 MPa or less, 1200 MPa or less, 990 MPa or less, 790 MPa or less, 640 MPa or less, 590 MPa or less and even 390 MPa or less. In an embodiment, the pressure applied in the pressure and/or temperature treatment refers to the mean pressure applied in the pressure and/or temperature treatment. In an alternative embodiment, the pressure applied in the pressure and/or temperature treatment refers to the minimum pressure applied in the pressure and/or temperature treatment. In another alternative embodiment, the pressure applied in the pressure and/or temperature treatment refers to the mean pressure applied in the pressure and/or temperature treatment, wherein the mean pressure is calculated excluding any pressure which is applied for less than a critical time (as previously defined). For some applications, the maximum pressure applied in the pressure and/or temperature treatment may be relevant. In different embodiments, the maximum pressure in the pressure and/or temperature treatment is 105 MPa or more, 210 MPa or more, 310 MPa or more, 405 MPa or more, 640 MPa or more, 1260 MPa or more and even 2600 MPa or more. For some applications, excessive pressure is not recommendable. In different embodiments, the maximum pressure applied in the pressure and/or temperature treatment is 2100 MPa or less, 1200 MPa or less, 990 MPa or less, 790 MPa or less, 640 MPa or less, than 590 MPa or less, 490 MPa or less and even 390 MPa or less. In an embodiment, any pressure which is maintained less than a “critical time” (as previously defined) is not considered a maximum pressure. In an embodiment, the maximum pressure is applied for a “relevant time” (as previously defined). In an embodiment, the pressure is applied in a continuous way. In an embodiment, the pressure is applied in a continuous way for a “relevant time” (as previously defined). In an embodiment, at least part of the pressure of the fluid is applied directly over the component. In an embodiment, the pressure of the fluid is applied directly over the component. In an embodiment, when the component comprises internal features, at least part of the pressure of the fluid is applied directly over the internal features. In an embodiment, when the component comprises internal features, the pressure of the fluid is applied directly over the internal features. In an embodiment, when the component comprises internal features, the pressure of the particle fluidized bed is applied directly over the internal features.

For some applications, the temperature applied in the pressure and/or temperature treatment may be relevant to the mechanical properties of the manufactured component. The inventor has found that for some applications, a certain relation between the melting temperature of the powder or powder mixture used to manufacture the component and the temperature involved in the pressure and/or temperature treatment may be advantageous. In different embodiments, the temperature applied in the pressure and/or temperature treatment is below 0.94*Tm, below 0.84*Tm, below 0.74*Tm, below 0.64*Tm, below 0.44*Tm, below 0.34*Tm, below 0.29*Tm and even below 0.24*Tm, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In another alternative embodiment. Tm refers to the melting temperature of a powder mixture (as previously defined). For some applications, when only one powder is used, Tm is the melting temperature of the powder. In this context, the temperatures disclosed above are in kelvin. For some applications, the temperature should be maintained above a certain value. In different embodiments, the temperature applied in the pressure and/or temperature treatment is above 0.16*Tm, above 0.19*Tm, above 0.26*Tm, above 0.3*Tm, above 0.45*Tm, above 0.61*Tm, above 0.69*Tm, above 0.74*Tm and even above 0.88*Tm, being Tm the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm is the mean melting temperature of the metal comprising powder mixture (volume-weighted arithmetic mean, where the weights are the volume fractions). In other alternative embodiments, Tm refers to the melting temperature of a powder mixture (as previously defined). For some applications, when only one metallic powder is used, Tm is the melting temperature of the metallic powder. In this context, the temperatures disclosed above are in kelvin. For some applications, it is better to define the temperature applied in the pressure and/or temperature treatment in absolute terms. In different embodiments, the temperature applied in the pressure and/or temperature treatment is below 649° C., below 440° C., below 298° C., below 249° C., below 149° C., below 90° C., below 490° C. and even below 29° C. For some applications, the temperature applied should be maintained above a certain value. In different embodiments, the temperature applied in the pressure and/or temperature treatment is above −14° C., above 9° C., above 31° C., above 48° C., above 88° C., above 110° C., above 158° C., above 210° C., above 270° C. and even above 310° C. In an embodiment, the temperature applied in the pressure and/or temperature treatment refers to the maximum temperature applied in the pressure and/or temperature treatment. In an alternative embodiment, the temperature applied in the pressure and/or temperature treatment refers to the mean temperature applied in the pressure and/or temperature treatment. In an embodiment, the mean temperature is calculated excluding any temperature which is maintained for less than a “critical time” (as previously defined). For some applications, the maximum temperature applied in the pressure and/or temperature treatment may be relevant to the mechanical properties of the manufactured component. In different embodiments, the maximum temperature applied in the pressure and/or temperature treatment is less than 995° C., less than 495° C., less than 245° C., less than 145° C. and even less than 85° C. For some applications, the maximum temperature applied should be above a certain value. In different embodiments, the maximum temperature applied in the pressure and/or temperature treatment is at least 26° C., at least 46° C., at least 76° C., at least 106° C., at least 260° C., at least 460° C., at least 600° C. and even at least 860° C. In an embodiment, the maximum temperature is maintained for a “relevant time” (as previously defined). In an embodiment, any temperature which is maintained for less than a “critical time” (as previously defined) is not considered a maximum temperature. For some applications, the minimum temperature applied may be relevant. In different embodiments, the minimum temperature applied in the pressure and/or temperature treatment is −29° C., −2° C., 9° C., 16° C., 26° C. and even 76° C. For some applications, the minimum temperature applied should be below a certain value. In different embodiments, the minimum temperature applied in the pressure and/or temperature treatment is less than 99° C., less than 49° C. less than 19° C., less than 1° C., less than −6° C. and even less than −26° C. For some applications, the minimum temperature applied should be above a certain value. In different embodiments, the minimum temperature in the pressure and/or temperature treatment is at least −51° C. at least −16° C., at least 0.1° C., at least 11° C., at least 26° C., at least 51° C. and even at least 91° C. In an embodiment, the minimum temperature is maintained for a “relevant time” (as previously defined). In an embodiment, any temperature which is maintained less than a “critical time” (as previously defined) is not considered a minimum temperature. In an embodiment, the temperature in the pressure and/or temperature treatment refers to the temperature of the pressurized fluid used to apply the pressure in the pressure and/or temperature treatment. The inventor has found that for some applications, significant variations in the temperature of the pressurized fluid during the pressure and/or temperature treatment are advantageous. In different embodiments, the maximum temperature gradient of the pressurized fluid during the pressure and/or temperature treatment is more than 6° C., more than 11° C., more than 16° C., more than 21° C., more than 55° C., more than 105° C. and even more than 145° C. For some applications, the maximum temperature gradient should be limited below a certain value. In different embodiments, the maximum temperature gradient of the pressurized fluid during the pressure and/or temperature treatment is less than 380° C., less than 290° C., less than 245° C., less than 149° C., less than 94° C., less than 49° C., less than 24.4° C., less than 23° C. and even less than 19° C. For some applications, the maximum temperature gradient should be maintained for a certain time. In different embodiments, a certain time is at least 1 second, at least 21 second and even at least 51 second. For some applications, the application of the maximum temperature gradient should be limited. In different embodiments, a certain time is less than 4 minutes, less than 1 minute, less than 39 seconds, less than 19 seconds. In an embodiment, the maximum pressure and temperature achieved in the pressure and/or temperature treatment takes place at the same time.

For certain applications, the use of several cycles is advantageous. In an embodiment, at least two cycles of pressure and/or temperature treatment are applied. In another embodiment, at least three cycles of pressure and/or temperature treatment are applied.

The inventor has surprisingly found that for some applications, the shape retention can be maintained even for large components, when part of the organic material is eliminated during the pressure and/or temperature treatment. In an embodiment, at least part of the organic material is eliminated during the pressure and/or temperature treatment. For some applications, the thermal elimination of at least part of the organic material is advantageous. In an alternative embodiment, the organic material is totally eliminated during the pressure and/or temperature treatment. In contrast, for some applications, at least part of the organic material should remain in the manufactured component. In different embodiments, at least part of the organic material refers to 6 vol % or more, 11 vol % or more, 36 vol % or more, 52 vol % or more, 76 vol % or more and even 98 vol % or more. For certain applications, the total elimination of the organic material may be detrimental. In different embodiments, at least part of the organic material refers to 99 vol % or less, 79 vol % or less, 54 vol % or less, 29 vol % or less, 14 vol % or less. In another embodiment, at least part of the organic material refers to 9 vol % or less. In alternative embodiments, the above disclosed percentages are by weight (wt %).

Surprisingly, the inventor has found that for some applications the organic material can be capitalized as a source of carbon for oxide reduction. In an embodiment, at least part of the organic material is used as a source of carbon for oxide reduction. In an embodiment, the organic material is used as a source of carbon for oxide reduction. In different embodiments, at least part of the organic material refers to 0.1 vol % or more, to 0.6 vol % or more, to 3.1 vol % or more, to 26 vol % or more, to 51 vol % or more and even to 71 vol % or more. In different embodiments, at least part of the organic material refers to 94 vol % or less, to 64 vol % or less, to 44 vol % or less, to 14 vol % or less, to 4 vol % or less and even to 0.99 vol % or less. In alternative embodiments, the above disclosed percentages are by weight (wt %). In an embodiment, the organic material is a binder.

Many additional method steps can be applied in combination with the method disclosed in the preceding paragraphs. For some applications, a consolidation step and/or a densification step can be applied to the component. In an embodiment, the method further comprises the step of: applying a high pressure, high temperature treatment. In an embodiment, the high pressure, high temperature treatment comprises applying a hot isostatic pressing (HIP). In different embodiments, the pressure applied in the high temperature, high pressure treatment is 110 bar or more, 260 bar or more, 460 bar or more, 960 bar or more, 1260 bar or more and even 1600 bar or more. For some applications, excessive pressures may adversely affect the mechanical properties. In different embodiments, the pressure applied in the high temperature, high pressure treatment is 4900 bar or less, 3900 bar or less, 2900 bar or less, 2100 bar or less, 1600 bar or less, 1300 bar or less, 800 bar or less, 600 bar or less and even 490 bar or less. In different embodiments, the temperature in the high temperature, high pressure treatment is 0.46*Tm or more, 0.56*Tm or more, 0.66*Tm or more, 0.71*Tm or more, 0.76*Tm or more, 0.81*Tm or more and even 0.86*Tm or more. As said, it has been surprisingly found that for some applications it is advantageous to keep temperature rather low. In different embodiments, the temperature in the high temperature, high pressure treatment is 0.91*Tm or less, 0.89*Tm or less, 0.79*Tm or less, 0.74*Tm or less and even 0.69*Tm or less. In an embodiment, Tm is the melting temperature of the metallic powder with the lowest melting point in the powder mixture. In an alternative embodiment, Tm is the melting temperature of the metallic powder with the lowest melting point in the powder mixture which is a critical powder (as previously defined). In another alternative embodiment, Tm is the melting temperature of the metallic powder with the lowest melting point in the powder mixture which is a relevant powder (as previously defined). In another alternative embodiment, Tm refers to the melting temperature of a powder mixture (as previously defined). For some applications, when only one metallic powder is used, Tm is the melting temperature of the metallic powder. In this context, the temperatures disclosed above are in kelvin. The component obtained using the method steps disclosed in preceding paragraphs can be optionally subjected to a heat treatment to improve the mechanical properties of the manufactured component. For some applications, the application of a machining step and/or surface conditioning may be also advantageous.

All the embodiments disclosed above can be combined in any combination, provided that they are not mutually exclusive.

It has been long observed that for steels in general often very little variations have a very significant effect on the resulting properties, this is more even the case in steels employed for highly demanding applications like tool steels. To make matters worse in the measurement of steel properties often mistakes are made and thus results are reported that afterwards cannot be reproduced either due to the oversight of the special conditions that brought to such results or because such results came to be from an incorrect measurement. For this reason, after thousands of years from the first steel development by humankind, still today several hundred new inventions related to steels are being made every year. So, there are millions of steel related inventions on the open literature and those which are very singular in their attained values completely misaligned from the general believe are sometimes a true breakthrough and more often than not a result of improper measurement or reporting (some capital aspects leading to the physical aspects which control the desirable unexpected results were not known to the people conducting the experimentation and thus they were not reported). So, the researcher when finding a report claiming some accidentally found unexpected results is faced with the difficulty of discerning whether the results were correctly measured in the report or he is not capable of reproducing some very specific set of parameters which were also unknown to the scientist writing the original report and which are the true responsible of the outstanding results if those were indeed correctly measured. This being said, given the amount of accessible research on tool steels, it is almost unavoidable that some singular pieces will contradict generally accepted behaviors, and thus such general theories are doomed by mere probability to have documents contradicting them, another issue is whether those contradicting documents arise from wrongful measurements. Despite this, in this document references are made about generally accepted steel behavior theories. One such theory is the benefit to toughness of some elements in tool steels (like for example % Ni and % Co). Also, some tool steels used for aluminum die casting (like for example AISI H11 or AISI H13) where high yield strength at high temperature and high toughness are required have % Cr as main alloying element. The Autor has found that in the case of dies, molds and assimilable applications it boils down to the thickness of the block required to obtain the required die. This thickness is known to the specialist and is related to the piece to be manufactured with the die and the available equipment to manufacture the piece, but in a general case it can be roughly approximated by taking the smaller of (1.5*thickness of the piece) and (thickness of the piece+150 mm) as the relevant thickness [as thickness of the piece is to be understood the maximum difference in heights, that is to say if the piece is left on a flat table, the maximum height from the table surface reached by any point of the piece]. For thickness smaller than 300 mm but larger than 60 mm often tool materials with a % Cr above 3% are taken. This is because it has been found that good compromise of mechanical properties can be achieved in highly demanding tooling applications if the % Cr is above 3% and mostly when it is between 3.5-5% (in some cases between 3 and 9.5%). In all those cases the % Cr is responsible to assure the preferred microstructure is attained in the final component. This desired microstructure mostly consists in tempered martensite, known to provide exceptionally good hardness-toughness compromises. According to the literature this is so because % Cr is very effective at preventing undesirable transformation. Besides the % Cr, other elements are present to provide other desirable applications for the intended application. For example in the case of Die casting applications, generally hot work tool steels like AISI H₁₁ or H₁₃ are used, which incorporate between 0.5-1% of % V and also between 1%-2% of % Mo to provide the desired carbides for that application (mostly secondary carbides), while High Speed Steels (HSS) traditionally incorporate much higher levels of alloying elements aiming at developing hard primary carbides with the intention of providing very high wear resistance, for example an AISI T15 will incorporate to the roughly 4% mentioned % Cr over 4.5% of % V, around 12% of % W and about 5% of % Co so altogether much more alloying for the purpose of having excellent wear resistance but with the same underlying strategy to attain the desired final microstructure. In some cold work tool steels higher % Cr quantities are used because it is desirable to have part of the % Cr incorporate in the primary carbides (example: the case in ledeburitic tool steels like AISI D2). Many other compositions have been developed with other % Cr contents, and while some of the ones with higher % Cr have had a moderate success, the ones with lower % Cr have only had success in a couple occasions and for rather small components. One significant breakthrough was the circumventing of this problematic by using steels with lower % Cr carefully picking the alloying of such steels and intentionally attaining microstructures which traditionally were known as undesirable but proved to surprisingly present exceptional properties. To summarize, until now it is either 3-9% Cr, lower % Cr but very small components or lower % Cr and structures other than tempered martensite. Within the present invention, the inventor has found that unexpectedly high properties can be achieved for large components with materials having low % Cr without the need of using complex, and difficult to reproduce microstructures. To such end the following method has been developed:
Step 1: Providing a component geometry defined by voxels.
Step 2: At least partially manufacturing the component with a manufacturing process comprising an additive manufacturing step.
Step 3: Taking the necessary steps, if any, to assure that at least part of the manufactured component comprises the right composition in terms of mean composition—in case local segregation is present —.
Step 4: Applying a correct quench to the component.

In an embodiment, local segregation refers to micro-segregation. In an embodiment, local segregation refers to the segregation than can arise by lack of homogeneity when mixing more than one powder with different compositions. In an embodiment, local segregation refers to the segregation than can arise by lack of homogeneity when mixing more than one powder with different compositions and applying a heat treatment involving incomplete diffusion.

For any component requiring high precision and incorporating a manufacturing step where somewhat uncontrolled distortion is brought to the component generally poses a big challenge in terms of centering the component, deciding the amount of surplus to be left for a precision machining step taking place after the step introducing the uncontrolled distortion and very often deciding how to allocate the surplus (centering of the piece prior to machining) to minimize the machining efforts while making sure the final component has the desired dimensions with the appropriate tolerance level. For those appreciating examples in the explanation of concepts, a manufacturing step where somewhat uncontrolled distortion is brought to the component is for example a heat treatment incorporating a quenching step (where it is fairly easy to evaluate an uppercut for the expected distortion but not the exact amount, therefore requiring machining stock if required tolerances are tight). This placing operation to properly orient the piece and thus be able to decide and implement the proper machining strategy is laborious and costly. It often involves several precise measurements of outside features of the part, and often the more critical geometrical aspects are the ones that are measured to assure the maximum precision on those features. The inventor has found that for many applications an orientation or placement based on external features or geometrical characteristics of the part are not the best and can severely limit the functionality of the piece. The inventor has found that often a placement taking as a reference an internal feature of the part or component is much more advantageous. To the knowledge of the inventor this way of proceeding is new. In an embodiment, the definition of internal feature described in the present text is used. In an embodiment, the general definition of internal feature is used. In an embodiment, an internal feature is any geometrical aspect that cannot be measured by contact. In an embodiment, a geometrical aspect is an interface between the material of the piece and component and a gas. In an embodiment, the gas is air. In an embodiment, an internal feature is any geometrical aspect that cannot be measured by radiation (light, laser, . . . ) that has a penetration depth in the material of less than 1 mm. In an embodiment, an internal feature is any geometrical aspect that cannot be measured with a machine with a measuring head. In an embodiment, proper measurement of internal features is performed trough radiation. In an embodiment, the radiation is ionizing radiation. In an embodiment, the radiation is non-ionizing radiation. In an embodiment, proper measurement of internal features is performed trough radiation with a penetration in the material of the component greater of 1 mm with less than 50% intensity loss. In an embodiment, proper measurement of internal features is performed trough radiation of the correct wavelength. In some cases the inventor has found that rather high frequency radiation is preferable. In an embodiment, the correct wavelength is between 10⁻¹⁶ and 8*10⁻⁷ meters. In an embodiment, the correct wavelength is between 1.2*10⁻¹⁵ and 9*10⁻⁹ meters. In an embodiment, the correct wavelength is between 1.2*10⁻¹¹ and 9*10⁻¹⁰ meters. In an embodiment, the correct wavelength is between 1,2*10⁻¹² and 9*10⁻⁹ meters. In an embodiment, the correct wavelength is between 1.2*10⁻¹¹ and 9*10⁻⁹ meters. In an embodiment, the correct wavelength is between 1.2*10⁻¹⁴ and 9*10⁻¹⁰ meters. In an embodiment, the correct wavelength is between 1.2*10⁻¹² and 9*10⁻¹⁰ meters. In an embodiment, the correct wavelength is between 1.2*10⁻¹¹ and 9*10⁻¹⁰ meters. In some cases lower frequencies are desirable. In an embodiment, the correct wavelength is between 1.2*10⁻⁴ and 9*10⁴ meters. In an embodiment, the correct wavelength is between 1.2*10⁻⁴ and 90 meters. In an embodiment, the correct wavelength is between 1.2*10⁻⁴ and 9 meters. In an embodiment, the correct wavelength is between 1.2*10⁻⁴ and 0.9 meters. In an embodiment, the correct wavelength is between 1.2*10⁻² and 9*10⁴ meters. In an embodiment, the correct wavelength is between 1.2*10⁻² and 90 meters. In an embodiment, the correct wavelength is between 1.2*10⁻² and 0.9 meters. In an embodiment, proper measurement of internal features is performed trough computer tomography. This can be a stand alone invention, described by the following method:
Step 1: Providing a component comprising internal features whose manufacturing comprises an additive manufacturing step.
Step 2: Performing a proper measurement of at least some of the internal features.
Step 3: generating a subtractive manufacturing strategy taking into account real placement of internal features.
Step 4: Performing a subtractive manufacturing step.

In an embodiment, subtractive manufacturing comprises chip removal trough machining. In an embodiment, subtractive manufacturing comprises material removal trough electro-erosion. In an embodiment, subtractive manufacturing comprises material removal trough wire electro-erosion (EDM). In an embodiment, subtractive manufacturing comprises material removal trough penetration electro-erosion. In an embodiment, subtractive manufacturing comprises material removal trough grinding. In an embodiment, subtractive manufacturing comprises material removal trough polishing. In an embodiment, subtractive manufacturing comprises material removal trough lapping. In an embodiment, subtractive manufacturing comprises material removal trough the generation of chips. In an embodiment, subtractive manufacturing comprises material removal trough milling. In an embodiment, subtractive manufacturing comprises material removal trough turning. In an embodiment, generating a subtractive manufacturing strategy taking into account real placement of internal features is performed trough a strategy that comprises the linking of real placement of internal features to external features that can be measured and used as reference in at least one of the subtractive manufacturing machines.

For one of several plausible embodiments, the method can be described as:
Step 1: Providing a component comprising internal features whose manufacturing comprises an additive manufacturing step.
Step 2: Performing a proper measurement of the internal features by means of radiation with a wavelength between 10⁻¹⁶ and 8*10⁻⁷ meters.
Step 3: generating a subtractive manufacturing strategy taking into account real placement of at least some of the internal features. The strategy comprises the linking of real placement of internal features to external features that can be measured and used as reference in at least one of the subtractive manufacturing machines.
Step 4: Performing a subtractive manufacturing step comprising chip removal trough machining.

The method disclosed in the preceding paragraphs can be implemented with variations to the foregoing embodiments that can meet the purpose described above. These embodiments serving the same, equivalent or similar purpose can replace the features disclosed above are all included in the technical scope of the method unless otherwise stated.

Any embodiment disclosed in this document can be combined among them in any combination, provided that they are not mutually exclusive.

All the embodiments disclosed in this document can be combined among them in any combination, provided that they are not mutually exclusive. Some non-limiting examples are as follows: [1]A method to manufacture a component comprising the following steps: —providing a powder or powder mixture: —a forming step, wherein an additive manufacturing method is applied to form the component; —a consolidation step, wherein a consolidation treatment is applied; and —optionally, a densification step, wherein a high temperature, high pressure treatment is applied.[2]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —a densification step, wherein a high temperature, high pressure treatment is applied.[3]A method to manufacture a component comprising the following steps: —providing a powder or powder mixture; —a forming step, wherein an additive manufacturing method is applied to form the component; —a debinding step; —a consolidation step, wherein a consolidation treatment is applied; and —optionally, a densification step, wherein a high temperature, high pressure treatment is applied.[4]A method to manufacture a component comprising the following steps: —providing a powder or powder mixture; —a forming step, wherein an additive manufacturing method is applied to form the component; —applying a pressure and/or temperature treatment; —a debinding step; —a consolidation step, wherein a consolidation treatment is applied; and —optionally, a densification step, wherein a high temperature, high pressure treatment is applied.[5]A method to manufacture a component comprising the following steps: —providing a powder or powder mixture; —a forming step, wherein an additive manufacturing method is applied to form the component; —a debinding step; —applying a pressure and/or temperature treatment; —a consolidation step, wherein a consolidation treatment is applied; and —optionally, a densification step, wherein a high temperature, high pressure treatment is applied.[6]A method to manufacture a component comprising the following steps: —providing a powder or powder mixture; —a forming step, wherein an additive manufacturing method is applied to form the component: —applying a pressure and/or temperature treatment; —a debinding step; —applying a pressure and/or temperature treatment; —a consolidation step, wherein a consolidation treatment is applied; and —optionally, a densification step, wherein a high temperature, high pressure treatment is applied.[7]A method to manufacture a component comprising the following steps: —providing a metallic powder or metal comprising powder mixture; —a forming step, wherein an additive manufacturing method is applied to form the component; —a fixing step, wherein the oxygen and/or nitrogen level of the metallic part of the component is set: —a consolidation step, wherein a consolidation treatment is applied: and —optionally, a densification step, wherein a high temperature, high pressure treatment is applied.[8]A method to manufacture a component comprising the following steps: —providing a powder or powder mixture: —a forming step, wherein an additive manufacturing method is applied to form the component; —a fixing step, wherein the oxygen and/or nitrogen level of the metallic part of the component is set: —a consolidation step, wherein a consolidation treatment is applied: and —a densification step, wherein a high temperature, high pressure treatment is applied.[9]A method to manufacture a component comprising the following steps: —providing a metallic powder or metal comprising powder mixture; —a forming step, wherein an additive manufacturing method is applied to form the component; —a debinding step: —a fixing step, wherein the oxygen and/or nitrogen level of the metallic part of the component is set; —a consolidation step, wherein a consolidation treatment is applied; and —optionally, a densification step, wherein a high temperature, high pressure treatment is applied.[10]A method to manufacture a component comprising the following steps: —providing a metallic powder or metal comprising powder mixture; —a forming step, wherein an additive manufacturing method is applied to form the component: —a debinding step; —a fixing step, wherein the oxygen and/or nitrogen level of the metallic part of the component is set; —a consolidation step, wherein a consolidation treatment is applied; and —a densification step, wherein a high temperature, high pressure treatment is applied.[11]A method to manufacture a component comprising the following steps: —providing a metallic powder or metal comprising powder mixture: —a forming step, wherein an additive manufacturing method is applied to form the component; —applying a pressure and/or temperature treatment; —a debinding step; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied.[12]A method to manufacture a component comprising the following steps: —providing a powder or powder mixture; —a forming step, wherein an additive manufacturing method is applied to form the component; —applying a pressure and/or temperature treatment; —a debinding step; —applying a pressure and/or temperature treatment; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied.[13]A method to manufacture a component comprising the following steps: —providing a metallic powder or metal comprising powder mixture; —a forming step, wherein an additive manufacturing method is applied to form the component; —applying a pressure and/or temperature treatment: —a fixing step, wherein the oxygen and/or nitrogen level of the metallic part of the component is set; —a consolidation step, wherein a consolidation treatment is applied; and —optionally, a densification step, wherein a high temperature, high pressure treatment is applied.[14]A method to manufacture a component comprising the following steps: —providing a powder or powder mixture; —a forming step, wherein an additive manufacturing method is applied to form the component; —optionally, applying a pressure and/or temperature treatment; —optionally, a debinding step; —optionally, applying a pressure and/or temperature treatment: —optionally, a fixing step, wherein the oxygen and/or nitrogen level of the metallic part of the component is set; —optionally, a consolidation step, wherein a consolidation treatment is applied; and —optionally, a densification step, wherein a high temperature, high pressure treatment is applied: —optionally, applying a heat treatment and/or machining.[15]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied; wherein the volume of the component is more than 2% and less than 89% of the rectangular cuboid with the minimum possible volume which contains the component.[16]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied; wherein the volume of the component is more than 2% and less than 89% of the volume of the cuboid shaped with the working surface of the component, wherein the cuboid shaped with the working surface of the component is defined as the rectangular cuboid with the minimum possible volume which contains the component, wherein the face of the rectangular cuboid that is in contact with the working surface of the component is substituted by a face with a geometrical shape that is coincident with the geometrical shape of the working surface of the component and has the minimum possible area.[17]A method to manufacture a component comprising the following steps: —providing a metallic powder or metal comprising powder mixture; —a forming step, wherein an additive manufacturing method is applied to form the component; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied: wherein the volume of the component is more than 2% and less than 89% of the volume of the rectangular cuboid with the minimum possible volume which contains the component.[18]A method to manufacture a component comprising the following steps: —providing a metallic powder or metal comprising powder mixture; —a forming step, wherein an additive manufacturing method is applied to form the component; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied; wherein the volume of the component is more than 2% and less than 89% of the volume of the cuboid shaped with the working surface of the component, wherein the cuboid shaped with the working surface of the component is defined as the rectangular cuboid with the minimum possible volume which contains the component, wherein the face of the rectangular cuboid that is in contact with the working surface of the component is substituted by a face with a geometrical shape that is coincident with the geometrical shape of the working surface of the component and has the minimum possible area.[19]A method to manufacture a component comprising the following steps: —providing a metallic powder or metal comprising powder mixture: —a forming step, wherein an additive manufacturing method is applied to form the component; —a consolidation step, wherein a consolidation treatment is applied; and —optionally, a densification step, wherein a high temperature, high pressure treatment is applied; wherein the significant cross-section of the component is 0.19 times or less the area of the largest rectangular face of the rectangular cuboid with the minimum possible volume which contains the component.[20]A method to manufacture a component comprising the following steps: —providing metallic powder or metal comprising powder mixture: —a forming step, wherein an additive manufacturing method is applied to form the component; —a consolidation step, wherein a consolidation treatment is applied; and —optionally a densification step, wherein a high temperature, high pressure treatment is applied: wherein the significant cross-section of the component is more than 0.2 mm² and less than 2900000 mm². [21]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied; wherein the significant thickness of the component is more than 0.12 mm and less than 1900 mm.[22]A method to manufacture a component comprising the following steps: —providing a metallic powder or metal comprising powder mixture: —a forming step, wherein an additive manufacturing method is applied to form the component; —a fixing step, wherein the oxygen and/or nitrogen level of the metallic part of the component is set: —a consolidation step, wherein a consolidation treatment is applied; and —optionally, a densification step, wherein a high temperature, high pressure treatment is applied; wherein the significant thickness of the component is more than 0.12 mm and less than 1900 mm.[23]A method to manufacture a component comprising the following steps: —providing a metallic powder or metal comprising powder mixture; —a forming step, wherein an additive manufacturing method is applied to form the component: —a debinding step; —a consolidation step, wherein a consolidation treatment is applied; and —optionally, a densification step, wherein a high temperature, high pressure treatment is applied; wherein the significant thickness of the component is more than 0.12 mm and less than 580 mm,[24]A method to manufacture a component comprising the following steps: —providing a metallic powder or metal comprising powder mixture: —a forming step, wherein an additive manufacturing method is applied to form the component; —a fixing step, wherein the oxygen and/or nitrogen level of the metallic part of the component is set; —a debinding step; —a consolidation step, wherein a consolidation treatment is applied; and —optionally a densification step, wherein a high temperature, high pressure treatment is applied; wherein the significant thickness of the component is more than 0.12 mm and less than 580 mm.[25]A method to manufacture a component comprising the following steps: —providing a metallic powder or metal comprising powder mixture; —a forming step, wherein an additive manufacturing method is applied to form the component; —a fixing step, wherein the oxygen level of the metallic part of the component is set to less than 390 ppm; —a consolidation step, wherein a consolidation treatment is applied; and —optionally, a densification step, wherein a high temperature, high pressure treatment is applied.[26]A method to manufacture a component comprising the following steps: —providing a metallic powder or metal comprising powder mixture; —a forming step, wherein an additive manufacturing method is applied to form the component; —a fixing step, wherein the oxygen level of the metallic part of the component is set to more than 0.02 ppm and less than 140 ppm; —a consolidation step, wherein a consolidation treatment is applied; and —optionally, a densification step, wherein a high temperature, high pressure treatment is applied.[27]A method to manufacture a component comprising the following steps: —providing a metallic powder or metal comprising powder mixture with an oxygen content of less than 48000 ppm; —a forming step, wherein an additive manufacturing method is applied to form the component; —a fixing step, wherein the oxygen level of the metallic part of the component is set to less than 390 ppm: —a consolidation step, wherein a consolidation treatment is applied; and —optionally, a densification step, wherein a high temperature, high pressure treatment is applied.[28]A method to manufacture a component comprising the following steps: —providing a metallic powder or metal comprising powder mixture; —a forming step, wherein an additive manufacturing method is applied to form the component: —a fixing step, wherein the oxygen level of the metallic part of the component is set to more than 0.02 ppm and less than 140 ppm; —a consolidation step, wherein a consolidation treatment is applied; and —optionally, a densification step, wherein a high temperature, high pressure treatment is applied.[29]A method to manufacture a component comprising the following steps: —providing a metallic powder or metal comprising powder mixture with an oxygen content of more than 620 ppm and less than 19000 ppm; —a forming step, wherein an additive manufacturing method is applied to form the component: —a fixing step, wherein the oxygen level of the metallic part of the component is set to more than 0.2 ppm and less than 140 ppm; —a consolidation step, wherein a consolidation treatment is applied; and —optionally a densification step, wherein a high temperature, high pressure treatment is applied.[30]A method to manufacture a component comprising the following steps: —providing a metallic powder or metal comprising powder mixture; —a forming step, wherein an additive manufacturing method is applied to form the component; —a fixing step, wherein the oxygen level of the metallic part of the component is set to less than 99 ppm; —a consolidation step, wherein a consolidation treatment is applied; and —optionally, a densification step, wherein a high temperature, high pressure treatment is applied.[31]A method to manufacture a component comprising the following steps: —providing a metallic powder or metal comprising powder mixture; —a forming step, wherein an additive manufacturing method is applied to form the component; —a fixing step, wherein the nitrogen level of the metallic part of the component is set to more than 0.01 ppm and less than 49 ppm; —a consolidation step, wherein a consolidation treatment is applied; and —optionally, a densification step, wherein a high temperature, high pressure treatment is applied.[32]A method to manufacture a component comprising the following steps: —providing a metallic powder or metal comprising powder mixture with a nitrogen content of less than 9000 ppm; —a forming step, wherein an additive manufacturing method is applied to form the component: —a fixing step, wherein the nitrogen level of the metallic part of the component is set to less than 99 ppm; —a consolidation step, wherein a consolidation treatment is applied; and —optionally, a densification step, wherein a high temperature, high pressure treatment is applied.[33]A method to manufacture a component comprising the following steps: —providing a metallic powder or metal comprising powder mixture with a nitrogen content of more than 55 ppm and less than 9000 ppm; —a forming step, wherein an additive manufacturing method is applied to form the component; —a fixing step, wherein the nitrogen level of the metallic part of the component is set to more than 0.01 ppm and less than 49 ppm; —a consolidation step, wherein a consolidation treatment is applied; and —optionally a densification step, wherein a high temperature, high pressure treatment is applied.[34]A method to manufacture a component comprising the following steps: —providing a metallic powder or metal comprising powder mixture with an oxygen content of less than 48000 ppm and a nitrogen content of less than 9000 ppm; —a forming step, wherein an additive manufacturing method is applied to form the component: —a fixing step, wherein the oxygen level of the metallic part of the component is set to less than 390 ppm and the nitrogen level of the metallic part of the component is set to less than 99 ppm: —a consolidation step, wherein a consolidation treatment is applied; and —optionally, a densification step, wherein a high temperature, high pressure treatment is applied.[35]A method to manufacture a component comprising the following steps: —providing a metallic powder or metal comprising powder mixture with an oxygen content of more than 620 ppm and less than 19000 ppm and a nitrogen content of more than 55 ppm and less than 9000 ppm; —a forming step, wherein an additive manufacturing method is applied to form the component: —a fixing step, wherein the oxygen level of the metallic part of the component is set to more than 0.2 ppm and less than 140 ppm and the nitrogen level of the metallic part of the component is set to more than 0.06 ppm and less than 49 ppm: —a consolidation step, wherein a consolidation treatment is applied; and —optionally, a densification step, wherein a high temperature, high pressure treatment is applied.[36]A method to manufacture a component comprising the following steps: —providing a metallic powder or metal comprising powder mixture; —a forming step, wherein an additive manufacturing method is applied to form the component: —a consolidation step, wherein a consolidation treatment is applied; and —optionally, a densification step, wherein a high temperature, high pressure treatment is applied; wherein the % NMVS in the metallic part of the component after the forming step is above 6%.[37]A method to manufacture a component comprising the following steps: —providing a metallic powder or metal comprising powder mixture; —a forming step, wherein an additive manufacturing method is applied to form the component: —a consolidation step, wherein a consolidation treatment is applied; and —optionally, a densification step, wherein a high temperature, high pressure treatment is applied; wherein the % NMVS in the metallic part of the component after the forming step is above 21% and below 99.8%.[38]A method to manufacture a component comprising the following steps: —providing a metallic powder or metal comprising powder mixture: —a forming step, wherein an additive manufacturing method is applied to form the component; —a consolidation step, wherein a consolidation treatment is applied; and —optionally, a densification step, wherein a high temperature, high pressure treatment is applied; wherein the % NMVS in the metallic part of the component after the forming step is above 21% and wherein the % NMVS in the metallic part of the component after the consolidation stop is below 14%.[39]A method to manufacture a component comprising the following steps: —providing a metallic powder or metal comprising powder mixture; —a forming step, wherein an additive manufacturing method is applied to form the component: —a consolidation step, wherein a consolidation treatment is applied; and —optionally, a densification step, wherein a high temperature, high pressure treatment is applied: wherein the % NMVS in the metallic part of the component after the forming step is above 31% and below 99.8% and wherein the % NMVS in the metallic part of the component after the consolidation step is above 0.02% and below 24%.[40]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied; wherein the percentage of reduction of NMVS in the metallic part of the component after the consolidation step is above 6%,[41]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied; wherein the apparent density of the metallic part of the component after the forming step is less than 98.4%.[42]A method to manufacture a component comprising the following steps: —providing a metallic powder or metal comprising powder mixture: —a forming step, wherein an additive manufacturing method is applied to form the component; —a consolidation step, wherein a consolidation treatment is applied; and —optionally a densification step, wherein a high temperature, high pressure treatment is applied; wherein the apparent density of the metallic part of the component after the forming step is higher than 51% and less than 99.8%.[43]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied: wherein the apparent density of the metallic part of the component after the forming step is higher than 51% and wherein the apparent density of the metallic part of the component after the consolidation step is higher than 81%.[44]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied; wherein the higher of the metallic part of the component after the forming step is higher than 51% and less than 99.8% and wherein the apparent density of the metallic part of the component after the consolidation step is higher than 81% and less than 99.8%.[45]A method to manufacture a component comprising the following steps: —providing a metallic powder or metal comprising powder mixture; —a forming step, wherein an additive manufacturing method is applied to form the component; —a consolidation step, wherein a consolidation treatment is applied: and —a densification step, wherein a high temperature, high pressure treatment is applied; wherein the apparent density of the metallic part of the component after the forming step is higher than 51%; wherein the apparent density of the metallic part of the component after the consolidation step is higher than 81% and wherein the apparent density of the metallic part of the component after the high temperature, high pressure treatment is higher than 96%.[46]A method to manufacture a component comprising the following steps: —providing a metallic powder or metal comprising powder mixture; —a forming step, wherein an additive manufacturing method is applied to form the component: —a consolidation step, wherein a consolidation treatment is applied; and —a densification step, wherein a high temperature, high pressure treatment is applied; wherein the higher of the metallic part of the component after the forming step is higher than 51% and less than 96.9%; wherein the apparent density of the metallic part of the component after the consolidation step is higher than 81% and less than 98.9% and wherein the apparent density of the metallic part of the component after the high temperature, high pressure treatment is higher than 98.2% and less than 99.98%.[47]A method to manufacture a component comprising the following steps: —providing a metallic powder or metal comprising powder mixture; —a forming step, wherein an additive manufacturing method is applied to form the component; —a debinding step; —applying a pressure and/or temperature treatment; —a consolidation step, wherein a consolidation treatment is applied; and —a densification step, wherein a high temperature, high pressure treatment is applied; wherein the apparent density of the metallic part of the component after the forming step is higher than 51% and less than 96.9%: wherein the apparent density of the metallic part of the component after the consolidation step is higher than 81% and less than 98.9% and wherein the apparent density of the metallic part of the component after the high temperature, high pressure treatment is higher than 98.2% and less than 99.98%.[48]A method to manufacture a component comprising the following steps: —providing a powder or powder mixture comprising at least a metal or a metal alloy in powdered form; —a forming step, wherein an additive manufacturing method is applied to form the component; —a consolidation step, wherein a consolidation treatment is applied: and —a densification step, wherein a high temperature, high pressure treatment is applied; wherein the higher of the metallic part of the component after the forming step is higher than 51% and less than 96.9%; wherein the apparent density of the component after the consolidation step is higher than 81% and less than 98.9% and wherein the apparent density of the metallic part of the component after the high temperature, high pressure treatment is higher than 99.2%.[49]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied; wherein the % NMVC in the metallic part of the component after the forming step is below 49%.[50]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied; wherein the % NMVC in the metallic part of the component after the forming step is above 0.3% and below 49%.[51]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied: —optionally, a densification step, wherein a high temperature, high pressure treatment is applied: wherein the % NMVC in the metallic part of the component after the forming step is below 49% and wherein the % NMVC in the metallic part of the component after the consolidation step is below 9%.[52]A method to manufacture a component comprising the following steps: —providing a metallic powder or metal comprising powder mixture; —a forming step, wherein an additive manufacturing method is applied to form the component: —a debinding step; —applying a pressure and/or temperature treatment; —a consolidation step, wherein a consolidation treatment is applied; and —optionally, a densification step, wherein a high temperature, high pressure treatment is applied; wherein the % NMVC in the metallic part of the component after the forming step is below 49% and wherein the % NMVC in the metallic part of the component after the consolidation step is below 9%.[53]A method to manufacture a component comprising the following steps: —providing a metallic powder or metal comprising powder mixture; —a forming step, wherein an additive manufacturing method is applied to form the component; —a consolidation step, wherein a consolidation treatment is applied; and —optionally, a densification step, wherein a high temperature, high pressure treatment is applied: wherein the % NMVC in the metallic part of the component after the forming step is above 6.2% and below 49% and wherein the % NMVC in the metallic part of the component after the consolidation step is above 0.002% and below 4%.[54]A method to manufacture a component comprising the following steps: —providing a metallic powder or metal comprising powder mixture with an oxygen content of more than 620 ppm and less than 19000 ppm and a nitrogen content of less than 900 ppm; —a forming step, wherein an additive manufacturing method is applied to form the component; —a fixing step, wherein the oxygen level of the metallic part of the component is set to more than 0.2 ppm and less than 140 ppm and the nitrogen level of the metallic part of the component is set to more than 0.06 ppm and less than 49 ppm: —a consolidation step, wherein a consolidation treatment is applied; and —a densification step, wherein a high temperature, high pressure treatment is applied; wherein the largest cross-section of the component is 0.79 times or less the area of the largest rectangular face of the rectangular cuboid with the minimum possible volume which contains the component.[55]A method to manufacture a component comprising the following steps: —providing a metallic powder or metal comprising powder mixture with an oxygen content of more than 250 ppm and less than 9000 ppm and a nitrogen content of more than 12 ppm; —a forming step, wherein an additive manufacturing method is applied to form the component: —a fixing step, wherein the oxygen level of the metallic part of the component is set to more than 0.02 ppm and less than 90 ppm and the nitrogen level of the metallic part of the component is set to more than 0.01 ppm and less than 19 ppm: —a consolidation step, wherein a consolidation treatment is applied: and —a densification step, wherein a high temperature, high pressure treatment is applied: wherein the mean cross-section of the component is more than 0.2 mm² and less than 2900000 mm², wherein the 20% of the largest cross-sections and the 20% of the smallest cross-sections are not considered to calculate the mean cross-section, being the cross-sections of the component each of the minimum cross-sections of the component calculated from each rectangular cubic voxel which is totally comprised in the component, wherein the number of rectangular cuboid voxels comprised in the component is calculated from Vrc=V/n³ being Vrc the volume of the rectangular cubic voxels in m³, V is the volume of the rectangular cuboid in m³ and n⁰ is the number of rectangular cuboid voxels which are contained in the rectangular cuboid, being n a natural number which is more than 11 and less than 990000, provided that the minimum cross-section of the component associated to each rectangular cubic voxel is the minimum cross-section of the component which comprises the geometrical center of the rectangular cuboid voxel.[56]A method to manufacture a component comprising the following steps: —providing a metallic powder or metal comprising powder mixture with an oxygen content of more than 250 ppm and less than 9000 ppm and a nitrogen content of more than 12 ppm: —a forming step, wherein an additive manufacturing method is applied to form the component; —a debinding step; —applying a pressure and/or temperature treatment; —a fixing step, wherein the oxygen level of the metallic part of the component is set to more than 0.02 ppm and less than 90 ppm and the nitrogen level of the metallic part of the component is set to more than 0.01 ppm and less than 19 ppm: —a consolidation step, wherein a consolidation treatment is applied; and —a densification step, wherein a high temperature, high pressure treatment is applied; wherein the mean cross-section of the component is more than 0.2 mm² and less than 2900000 mm², wherein the 20% of the largest cross-sections and the 20% of the smallest cross-sections are not considered to calculate the mean cross-section, being the cross-sections of the component each of the minimum cross-sections of the component calculated from each rectangular cubic voxel which is totally comprised in the component, wherein the number of rectangular cuboid voxels comprised in the component is calculated from Vrc=V/n³ being Vrc the volume of the rectangular cubic voxels in m3, V is the volume of the rectangular cuboid in m³ and n³ is the number of rectangular cuboid voxels which are contained in the rectangular cuboid, being n a natural number which is more than 11 and less than 990000, provided that the minimum cross-section of the component associated to each rectangular cubic voxel is the minimum cross-section of the component which comprises the geometrical center of the rectangular cuboid voxel.[57]A method to manufacture a component comprising the following steps: —providing a metallic powder or metal comprising powder mixture with an oxygen content of more than 250 ppm and a nitrogen content of more than 55 ppm and less than 9000 ppm; —a forming step, wherein an additive manufacturing method is applied to form the component; —a fixing step, wherein the oxygen level of the metallic part of the component is set to more than 0.2 ppm and less than 140 ppm and the nitrogen level of the metallic part of the component is set to more than 0.01 ppm and less than 49 ppm; —a consolidation step, wherein a consolidation treatment is applied; and —a densification step, wherein a high temperature, high pressure treatment is applied; wherein the mean cross-section of the component is more than 0.2 mm² and less than 49% of the area of the largest rectangular face of the rectangular cuboid with the minimum possible volume which contains the component.[58]A method to manufacture a component comprising the following steps: —providing a metallic powder or metal comprising powder mixture with an oxygen content of more than 1100 ppm and less than 48000 ppm and a nitrogen content of less than 9000 ppm; —a forming step, wherein an additive manufacturing method is applied to form the component: —a fixing step, wherein the oxygen level of the metallic part of the component is set to less than 390 ppm and the nitrogen level of the metallic part of the component is set to more than 1.2 ppm and less than 99 ppm: —a consolidation step, wherein a consolidation treatment is applied: and —a densification step, wherein a high temperature, high pressure treatment is applied; wherein the % NMVS in the metallic part of the component after the forming step is above 21% and wherein the % NMVS in the metallic part of the component after the consolidation step is below 14%.[59]A method to manufacture a component comprising the following steps: —providing a metallic powder or metal comprising powder mixture with an oxygen content of more than 1100 ppm and less than 48000 ppm and a nitrogen content of less than 9000 ppm; —a forming step, wherein an additive manufacturing method is applied to form the component; —a debinding step: —applying a pressure and/or temperature treatment; —a fixing step, wherein the oxygen level of the metallic part of the component is set to less than 390 ppm and the nitrogen level of the metallic part of the component is set to more than 1.2 ppm and less than 99 ppm: —a consolidation step, wherein a consolidation treatment is applied; and —a densification step, wherein a high temperature, high pressure treatment is applied; wherein the % NMVS in the metallic part of the component after the forming step is above 21% and wherein the % NMVS in the metallic part of the component after the consolidation step is below 14%.[60]A method to manufacture a component comprising the following steps: —providing a metallic powder or metal comprising powder mixture with an oxygen content of more than 620 ppm and less than 19000 ppm and a nitrogen content of more than 55 ppm and less than 490 ppm; —a forming step, wherein an additive manufacturing method is applied to form the component: —a fixing step, wherein the oxygen level of the metallic part of the component is set to more than 0.2 ppm and less than 140 ppm and the nitrogen level of the metallic part of the component is set to more than 0.06 ppm and less than 49 ppm: —a consolidation step, wherein a consolidation treatment is applied; and —a densification step, wherein a high temperature, high pressure treatment is applied; wherein the higher of the metallic part of the component after the forming step is higher than 71% and wherein the apparent density of the metallic part of the component after the consolidation step is higher than 81% and less than 99.8%.[61]A method to manufacture a component comprising the following steps: —providing a metallic powder or metal comprising powder mixture with an oxygen content of more than 620 ppm and less than 48000 ppm and a nitrogen content of less than 9000 ppm; —a forming step, wherein an additive manufacturing method is applied to form the component; —a fixing step, wherein the oxygen level of the metallic part of the component is set to less than 390 ppm and the nitrogen level of the metallic part of the component is set to less than 99 ppm: —a consolidation step, wherein a consolidation treatment is applied; and —a densification step, wherein a high temperature, high pressure treatment is applied; wherein the largest cross-section of the component is less than 19% of the area of the largest rectangular face of the rectangular cuboid with the minimum possible volume which contains the component and wherein the percentage of reduction of NMVS in the metallic part of the component after the consolidation step is above 6%.[62]A method to manufacture a component comprising the following steps: —providing a metallic powder or metal comprising powder mixture with an oxygen content of more than 620 ppm and less than 48000 ppm and a nitrogen content of less than 9000 ppm: —a forming step, wherein an additive manufacturing method is applied to form the component; —a debinding step; —applying a pressure and/or temperature treatment: —a fixing step, wherein the oxygen level of the metallic part of the component is set to less than 390 ppm and the nitrogen level of the metallic part of the component is set to less than 99 ppm; —a consolidation step, wherein a consolidation treatment is applied; and —a densification step, wherein a high temperature, high pressure treatment is applied: wherein the largest cross-section of the component is less than 19% of the area of the largest rectangular face of the rectangular cuboid with the minimum possible volume which contains the component and wherein the percentage of reduction of NMVS in the metallic part of the component after the consolidation step is above 6%.[63]A method to manufacture a component comprising the following steps: —providing a metallic powder or metal comprising powder mixture with an oxygen content of more than 620 ppm and less than 19000 ppm and a nitrogen content of more than 12 ppm and less than 9000 ppm; —a forming step, wherein an additive manufacturing method is applied to form the component; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; and —a densification step, wherein a high temperature, high pressure treatment is applied; wherein the mean cross-section of the component is 0.79 times or less the area of the largest rectangular face of the rectangular cuboid with the minimum possible volume which contains the component; wherein the % NMVS in the metallic part of the component after the forming step is above 31% and below 99.8% and wherein the % NMVS in the metallic part of the component after the consolidation step is above 0.02% and below 24%.[64]A method to manufacture a component comprising the following steps: —providing a metallic powder or metal comprising powder mixture with an oxygen content of more than 250 ppm and a nitrogen content of more than 12 ppm; —a forming step, wherein an additive manufacturing method is applied to form the component; —a fixing step, wherein the oxygen level of the metallic part of the component is set to more than 0.2 ppm and less than 140 ppm and the nitrogen level of the metallic part of the component is set to less than 99 ppm; —a consolidation step, wherein a consolidation treatment is applied; and —a densification step, wherein a high temperature, high pressure treatment is applied: wherein the largest cross-section of the component is more than 0.2 mm² and less than 49% of the area of the largest rectangular face of the rectangular cuboid with the minimum possible volume which contains the component; wherein the % NMVC in the metallic part of the component after the forming step is above 6.2% and below 49% and wherein the % NMVC in the metallic part of the component after the consolidation step is above 0.002% and below 4%.[65]A method to manufacture a component comprising the following steps: —providing a metallic powder or metal comprising powder mixture with an oxygen content of more than 620 ppm and less than 48000 ppm and a nitrogen content of more than 12 ppm and less than 900 ppm; —a forming step, wherein an additive manufacturing method is applied to form the component; —a fixing step, wherein the oxygen level of the metallic part of the component is set to less than 390 ppm and the nitrogen level of the metallic part of the component is set to less than 99 ppm; —a consolidation step, wherein a consolidation treatment is applied; and —a densification step, wherein a high temperature, high pressure treatment is applied; wherein the mean cross-section of the component is more than 0.2 mm² and less than 49% of the area of the largest rectangular face of the rectangular cuboid with the minimum possible volume which contains the component; wherein the % NMVC in the metallic part of the component after the forming step is below 49%; wherein the % NMVC in the metallic part of the component after the consolidation step is below 9%: wherein the higher of the metallic part of the component after the forming step is higher than 51%; wherein the apparent density of the metallic part of the component after the consolidation step is higher than 81% and wherein the apparent density of the metallic part of the component after the high temperature, high pressure treatment is higher than 96% and less than 99.98%.[66]A method to manufacture a component comprising the following steps: —providing a metallic powder or metal comprising powder mixture; —a forming step, wherein an additive manufacturing method is applied to form the component; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied; wherein the % NMVS in the metallic part of the component after the forming step is above 0.02% and below 99.8%; wherein the % NMVC in the metallic part of the component after the forming step is above 0.3% and below 64%; wherein the higher of the metallic part of the component after the forming step is higher than 21% and less than 99.8%; wherein the percentage of reduction of NMVS in the metallic part of the component after the consolidation step is above 2.1%; wherein the % NMVC in the metallic part of the component after the consolidation step is above 0.002% and below 9%; wherein the apparent density of the metallic part of the component after the consolidation step is higher than 81% and wherein the volume of the component is more than 2% and less than 89% of the rectangular cuboid with the minimum possible volume which contains the component.[67]A method to manufacture a component comprising the following steps: —providing a metallic powder or metal comprising powder mixture; —a forming step, wherein an additive manufacturing method is applied to form the component: —a debinding step; —applying a pressure and/or temperature treatment; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied, wherein the % NMVS in the metallic part of the component after the forming step is above 0.02% and below 99.8%; wherein the % NMVC in the metallic part of the component after the forming step is above 0.3% and below 64%: wherein the higher of the metallic part of the component after the forming step is higher than 21% and less than 99.8%; wherein the percentage of reduction of NMVS in the metallic part of the component after the consolidation step is above 2.1%; wherein the % NMVC in the metallic part of the component after the consolidation step is above 0.002% and below 9%: wherein the apparent density of the metallic part of the component after the consolidation step is higher than 81% and wherein the volume of the component is more than 2% k and less than 89% of the rectangular cuboid with the minimum possible volume which contains the component.[68]A method to manufacture a component comprising the following steps: —providing a metallic powder or metal comprising powder mixture; —a forming step, wherein an additive manufacturing method is applied to form the component; —a fixing step, wherein the oxygen and/or nitrogen level of the metallic part of the component is set: —a consolidation step, wherein a consolidation treatment is applied; and —optionally, a densification step, wherein a high temperature, high pressure treatment is applied; wherein the % NMVS in the metallic part of the component after the forming step is above 0.02% and below 99.8%; wherein the % NMVC in the metallic part of the component after the forming step is above 0.3% and below 64%; wherein the higher of the metallic part of the component after the forming step is higher than 21% and less than 99.8%; wherein the percentage of reduction of NMVS in the metallic part of the component after the consolidation step is above 2.1%; wherein the % NMVC in the metallic part of the component after the consolidation step is above 0.002% and below 9%: wherein the apparent density of the metallic part of the component after the consolidation step is higher than 81% and wherein the volume of the component is more than 2% k and less than 89% of the volume of the cuboid shaped with the working surface of the component, wherein the cuboid shaped with the working surface of the component is defined as the rectangular cuboid with the minimum possible volume which contains the component, wherein the face of the rectangular cuboid that is in contact with the working surface of the component is substituted by a face with a geometrical shape that is coincident with the geometrical shape of the working surface of the component and has the minimum possible area.[69]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —a forming step, wherein an additive manufacturing method is applied to form the component; —a fixing step, wherein the oxygen level of the metallic part of the component is set to more than 0.2 ppm and less than 390 ppm and the nitrogen level of the metallic part of the component is set to more than 0.06 ppm and less than 49 ppm: —a consolidation step, wherein a consolidation treatment is applied; and —a densification step, wherein a high temperature, high pressure treatment is applied; wherein the mean cross-section of the component is more than 0.2 mm² and less than 9000 mm², wherein the 20% of the largest cross-sections and the 20% of the smallest cross-sections are not considered to calculate the mean cross-section, being the cross-sections of the component each of the minimum cross-sections of the component calculated from each rectangular cubic voxel which is totally comprised in the component, wherein the number of rectangular cuboid voxels comprised in the component is calculated from Vrc=V/n³ being Vrc the volume of the rectangular cubic voxels in m³, V is the volume of the rectangular cuboid in m³ and n³ is the number of rectangular cuboid voxels which are contained in the rectangular cuboid, being n=41000, provided that the minimum cross-section of the component associated to each rectangular cubic voxel is the minimum cross-section of the component which comprises the geometrical center of the rectangular cuboid voxel; wherein the % NMVC in the metallic part of the component after the forming step is above 12% and below 24%; wherein the % NMVC in the metallic part of the component after the consolidation step is below 9%; wherein the higher of the metallic part of the component after the forming step is higher than 71% and less than 89.8%; wherein the apparent density of the metallic part of the component after the consolidation step is less than 89% and wherein the apparent density of the metallic part of the component after the high temperature, high pressure treatment is higher than 96%.[70]A method to manufacture a component comprising the following steps: —providing a metallic powder or metal comprising powder mixture with an oxygen content of more than 250 ppm and less than 19000 ppm, and a nitrogen content of more than 12 ppm and less than 9000 ppm; —a forming step, wherein an additive manufacturing method is applied to form the component; —a fixing step, wherein the oxygen level of the metallic part of the component is set to more than 0.2 ppm and less than 390 ppm and the nitrogen level of the metallic part of the component is set to more than 0.06 ppm and less than 49 ppm; —a consolidation step, wherein a consolidation treatment is applied; and —a densification step, wherein a high temperature, high pressure treatment is applied; wherein the % NMVC in the metallic part of the component after the forming step is above 12% and below 24%: wherein the % NMVC in the metallic part of the component after the consolidation step is below 9%; wherein the higher of the metallic part of the component after the forming step is higher than 71% and less than 89.8%: wherein the apparent density of the metallic part of the component after the consolidation step is less than 89% and wherein the apparent density of the metallic part of the component after the high temperature, high pressure treatment is higher than 96%.[71]A method to manufacture a component comprising the following steps: —providing a metallic powder or metal comprising powder mixture with an oxygen content of more than 250 ppm and less than 19000 ppm, and a nitrogen content of more than 12 ppm and less than 9000 ppm; —a forming step, wherein an additive manufacturing method is applied to form the component; —a debinding step; —applying a pressure and/or temperature treatment; —a fixing step, wherein the oxygen level of the metallic part of the component is set to more than 0.2 ppm and less than 390 ppm and the nitrogen level of the metallic part of the component is set to more than 0.06 ppm and less than 49 ppm: —a consolidation step, wherein a consolidation treatment is applied; and —a densification step, wherein a high temperature, high pressure treatment is applied; wherein the % NMVC in the metallic part of the component after the forming step is above 12% and below 24%; wherein the % NMVC in the metallic part of the component after the consolidation step is below 9%; wherein the higher of the metallic part of the component after the forming step is higher than 71% and less than 89.8%; wherein the apparent density of the metallic part of the component after the consolidation step is less than 89% and wherein the apparent density of the metallic part of the component after the high temperature, high pressure treatment is higher than 96%.[72]A method to manufacture a component comprising the following steps: —providing a metallic powder or metal comprising powder mixture with an oxygen content of more than 250 ppm and less than 19000 ppm and a nitrogen content of more than 55 ppm and less than 900 ppm; —a forming step, wherein an additive manufacturing method is applied to form the component: —a fixing step, wherein the oxygen level of the metallic part of the component is set to less than 140 ppm and the nitrogen level of the metallic part of the component is set to less than 49 ppm; —a consolidation step, wherein a consolidation treatment is applied; and —optionally, a densification step, wherein a high temperature, high pressure treatment is applied: wherein the % NMVS in the metallic part of the component after the forming step is above 31%; wherein the percentage of reduction of NMVS in the metallic part of the component after the consolidation step is above 81% and wherein the percentage of increase of the apparent density of the metallic part of the component after the consolidation step is below 14%.[73]A method to manufacture a component comprising the following steps: —providing a metallic powder or metal comprising powder mixture with an oxygen content of more than 250 ppm and less than 19000 ppm and a nitrogen content of more than 55 ppm and less than 900 ppm: —a forming step, wherein an additive manufacturing method is applied to form the component; —a fixing step, wherein the oxygen level of the metallic part of the component is set to less than 140 ppm and the nitrogen level of the metallic part of the component is set to less than 49 ppm; —a consolidation step, wherein a consolidation treatment is applied; and —optionally, a densification step, wherein a high temperature, high pressure treatment is applied; wherein the % NMVS in the metallic part of the component after the forming step is above 31%; wherein the percentage of reduction of NMVS in the metallic part of the component after the consolidation step is above 81%: wherein the percentage of increase of the apparent density of the metallic part of the component after the consolidation step is below 14% and wherein the volume of the component is more than 2% and less than 89% of the volume of the rectangular cuboid with the minimum possible volume which contains the component.[74]A method to manufacture a component comprising the following steps: —providing a metallic powder or metal comprising powder mixture with an oxygen content of more than 250 ppm and less than 19000 ppm and a nitrogen content of more than 55 ppm and less than 900 ppm; —a forming step, wherein an additive manufacturing method is applied to form the component; —a fixing step, wherein the oxygen level of the metallic part of the component is set to less than 140 ppm and the nitrogen level of the metallic part of the component is set to less than 49 ppm; —a consolidation step, wherein a consolidation treatment is applied; and —a densification step, wherein a high temperature, high pressure treatment is applied: wherein the % NMVS in the metallic part of the component after the forming step is above 31%; wherein the percentage of reduction of NMVS in the metallic part of the component after the consolidation step is above 81%; wherein the percentage of increase of the apparent density of the metallic part of the component after the consolidation step is below 14% and wherein the percentage of reduction of NMVC in the metallic part of the component after the high temperature, high pressure treatment is above 8%.[75]A method to manufacture a component comprising the following steps: —providing a metallic powder or metal comprising powder mixture with an oxygen content of more than 620 ppm and a nitrogen content of more than 110 ppm; —a forming step, wherein an additive manufacturing method is applied to form the component: —a fixing step, wherein the oxygen level of the metallic part of the component is set to less than 390 ppm and the nitrogen level of the metallic part of the component is set to less than 99 ppm; —a consolidation step, wherein a consolidation treatment is applied; and —optionally, a densification step, wherein a high temperature, high pressure treatment is applied; wherein the % NMVS in the metallic part of the component after the forming step is below 99.8% and wherein the percentage of reduction of NMVS in the metallic part of the component after the consolidation step is above 11%.[76]A method to manufacture a component comprising the following steps: —providing a metallic powder or metal comprising powder mixture with an oxygen content of more than 620 ppm and a nitrogen content of more than 110 ppm; —a forming step, wherein an additive manufacturing method is applied to form the component; —a debinding step; —applying a pressure and/or temperature treatment; —a fixing step, wherein the oxygen level of the metallic part of the component is set to less than 390 ppm and the nitrogen level of the metallic part of the component is set to less than 99 ppm; —a consolidation step, wherein a consolidation treatment is applied; and —optionally, a densification step, wherein a high temperature, high pressure treatment is applied; wherein the % NMVS in the metallic part of the component after the forming step is below 99.8% and wherein the percentage of reduction of NMVS in the metallic part of the component after the consolidation step is above 11%.[77]A method to manufacture a component comprising the following steps: —providing a metallic powder or metal comprising powder mixture; —a forming step, wherein an additive manufacturing method is applied to form the component, wherein the additive manufacturing method comprises the use of an organic material; —a consolidation step, wherein a consolidation treatment is applied; and —a densification step, wherein a high temperature, high pressure treatment is applied; —optionally, a densification step, wherein a high temperature, high pressure treatment is applied; wherein the % NMVS in the metallic part of the component after the consolidation step is above 0.02% and below 24%; wherein the percentage of reduction of NMVS in the metallic part of the component after the consolidation step is above 2.1% and wherein the percentage of increase of the apparent density of the metallic part of the component after the consolidation step is below 29%.[78]A method to manufacture a component comprising the following steps: —providing a metallic powder or metal comprising powder mixture; —a forming step, wherein an additive manufacturing method is applied to form the component, wherein the additive manufacturing method comprises the use of an organic material: —a consolidation step, wherein a consolidation treatment is applied; and —a densification step, wherein a high temperature, high pressure treatment is applied; wherein the % NMVS in the metallic part of the component after the consolidation step is above 0.02% and below 24%; wherein the percentage of reduction of NMVS in the metallic part of the component after the consolidation step is above 2.1%; wherein the percentage of increase of the apparent density of the metallic part of the component after the consolidation step is below 29% and wherein the percentage of reduction of NMVC in the metallic part of the component after the high temperature, high pressure treatment is above 3.6%.[79]A method to manufacture a component comprising the following steps: —providing a metallic powder or metal comprising powder mixture; —a forming step, wherein an additive manufacturing method is applied to form the component, wherein the additive manufacturing method comprises the use of a polymer and/or binder; —a consolidation step, wherein a consolidation treatment is applied; and —optionally, a densification step, wherein a high temperature, high pressure treatment is applied: wherein the % NMVS in the metallic part of the component after the forming step is above 31%; wherein the percentage of reduction of NMVS in the metallic part of the component after the consolidation step is above 51% and wherein the percentage of increase of the apparent density of the metallic part of the component after the consolidation step is below 9%.[80]A method to manufacture a component comprising the following steps: —providing a metallic powder or metal comprising powder mixture with an oxygen content of more than 620 ppm and less than 9000 ppm and a nitrogen content of less than 9000 ppm; —a forming step, wherein an additive manufacturing method is applied to form the component, wherein the additive manufacturing method comprises the use of an organic material; —applying a debinding to eliminate at least part of the organic material; —a fixing step, wherein the oxygen level of the metallic part of the component is set to less than 140 ppm and the nitrogen level of the metallic part of the component is set to more than 0.06 ppm; —a consolidation step, wherein a consolidation treatment is applied; and —a densification step, wherein a high temperature, high pressure treatment is applied: wherein the % NMVC in the metallic part of the component after the forming step is above 0.3% and below 64%; wherein the higher of the metallic part of the component after the forming step is higher than 31% and less than 79.8%; wherein the % NMVC in the metallic part of the component after the consolidation step is above 0.02% and below 0.9%; wherein the apparent density of the metallic part of the component after the consolidation step is higher than 81% and less than 98.9% and wherein the percentage of increase of the apparent density of the metallic part of the component after the consolidation step is above 6% and below 69%.[81]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm: —a forming step, wherein an additive manufacturing method is applied to form the component, wherein the additive manufacturing method comprises the use of an organic material: —applying a debinding to eliminate at least part of the organic material; —a fixing step, wherein the oxygen level of the metallic part of the component is set to more than 0.02 ppm and less than 140 ppm and the nitrogen level of the metallic part of the component is set to more than 0.01 ppm and less than 99 ppm; —a consolidation step, wherein a consolidation treatment is applied; and —optionally, a densification step, wherein a high temperature, high pressure treatment is applied; wherein the % NMVS in the metallic part of the component after the forming step is above 51% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.6% and below 4% and wherein the apparent density of the metallic part of the component after the consolidation step is higher than 86% and less than 99.8%.[82]A method to manufacture a component comprising the following steps: —providing a metallic powder or metal comprising powder mixture with an oxygen content of more than 620 ppm and less than 9000 ppm and a nitrogen content of less than 9000 ppm; —a forming step, wherein an additive manufacturing method is applied to form the component, wherein the additive manufacturing method comprises the use of an organic material; —a fixing step, wherein the oxygen level of the metallic part of the component is set to less than 140 ppm and the nitrogen level of the metallic part of the component is set to more than 0.06 ppm; —a consolidation step, wherein a consolidation treatment is applied; and —optionally, a densification step, wherein a high temperature, high pressure treatment is applied: wherein the % NMVS in the metallic part of the component after the forming step is above 31%: wherein the percentage of reduction of NMVS in the metallic part of the component after the consolidation step is above 26%; wherein the apparent density of the metallic part of the component after the consolidation step is less than 93.9% and wherein the percentage of increase of the apparent density of the metallic part of the component after the consolidation step is below 19%.[83]A method to manufacture a component comprising the following steps: —providing a metallic powder or metal comprising powder mixture: —a forming step, wherein an additive manufacturing method is applied to form the component, wherein the mean temperature employed in the additive manufacturing method is below 0.5*Tm, being Tm the melting temperature of the metallic powder with the lowest melting point in the powder mixture; —a consolidation step, wherein a consolidation treatment is applied; and —optionally, a densification step, wherein a high temperature, high pressure treatment is applied; wherein the % NMVS in the metallic part of the component after the forming step is above 6% and below 99.98%; wherein the higher of the metallic part of the component after the forming step is higher than 31% and less than 99.8%; wherein the % NMVS in the metallic part of the component after the consolidation step is above 0.06% and below 39% and wherein the percentage of increase of the apparent density of the metallic part of the component after the consolidation step is below 29%.[84]A method to manufacture a component comprising the following steps: —providing a metallic powder or metal comprising powder mixture; —a forming step, wherein an additive manufacturing method is applied to form the component, wherein the maximum temperature employed in the additive manufacturing method is below 0.46*Tm, being Tm the melting temperature of the metallic powder with the lowest melting point in the powder mixture, which is at least 0.06 wt % of the powder mixture; —a consolidation step, wherein a consolidation treatment is applied; and —optionally, a densification step, wherein a high temperature, high pressure treatment is applied; wherein the % NMVS in the metallic part of the component after the forming step is above 51% and below 98%; wherein the higher of the metallic part of the component after the forming step is higher than 41% and less than 89.8% and wherein the percentage of increase of the apparent density of the metallic part of the component after the consolidation step is below 19%.[85]A method to manufacture a component comprising the following steps: —providing a metallic powder or metal comprising powder mixture: —a forming step, wherein an additive manufacturing method is applied to form the component, wherein the maximum temperature employed in the additive manufacturing method is below 0.64*Tm, being Tm the melting temperature of the metallic powder with the lowest melting point in the powder mixture, which is at least 2.6 wt % of the powder mixture; —a consolidation step, wherein a consolidation treatment is applied; and —optionally, a densification step, wherein a high temperature, high pressure treatment is applied; wherein the % NMVS in the metallic part of the component after the forming step is above 51%; wherein the percentage of reduction of NMVS in the metallic part of the component after the consolidation step is above 51% and wherein the percentage of increase of the apparent density of the metallic part of the component after the consolidation step is below 14%.[86]A method to manufacture a component comprising the following steps: —providing a metallic powder or metal comprising powder mixture; —a forming step, wherein an additive manufacturing method is applied to form the component, wherein the mean temperature employed in the additive manufacturing method is above 0.59*Tm, being Tm the melting temperature of the metallic powder with the lowest melting point in the powder mixture which is at least 1.2 wt % of the powder mixture; —a consolidation step, wherein a consolidation treatment is applied; and —optionally, a densification step, wherein a high temperature, high pressure treatment is applied; wherein the % NMVS in the metallic part of the component after the forming step is above 0.02% and below 9%: wherein the apparent density of the metallic part of the component after the forming step is higher than 71% and less than 99.98% and wherein the percentage of increase of the apparent density of the metallic part of the component after the consolidation step is below 19%.[87]A method to manufacture a component comprising the following steps: —providing a metallic powder or metal comprising powder mixture with an oxygen content of more than 250 ppm and less than 4900 ppm and a nitrogen content of more than 12 ppm and less than 900 ppm: —a forming step, wherein an additive manufacturing method is applied to form the component, wherein the maximum temperature employed in the additive manufacturing method is above 0.64*Tm, being Tm the melting temperature of the metallic powder with the lowest melting point in the powder mixture; —a fixing step, wherein the oxygen level of the metallic part of the component is set to more than 1.2 ppm and less than 90 ppm and the nitrogen level of the metallic part of the component is set to more than 1.2 ppm and less than 49 ppm; and —optionally, a consolidation step, wherein a consolidation treatment is applied; —optionally, a densification step, wherein a high temperature, high pressure treatment is applied: wherein the apparent density of the metallic part of the component after the forming step is higher than 86% and less than 99.98%; wherein the % NMVS in the metallic part of the component after the forming step is above 0.02% and below 9% and wherein the percentage of reduction of NMVS in the metallic part of the component after the high temperature, high pressure treatment is above 0.22%.[88]A method to manufacture a component comprising the following steps: —providing a metallic powder or metal comprising powder mixture; —a forming step, wherein an additive manufacturing method is applied to form the component, wherein the maximum temperature employed in the additive manufacturing method is above 0.36*Tm, being Tm the melting temperature of the metallic powder with the lowest melting point in the powder mixture; —a fixing step, wherein the oxygen level of the metallic part of the component is set to more than 6 ppm and less than 90 ppm and the nitrogen level of the metallic part of the component is set to more than 0.06 ppm and less than 19 ppm; and —optionally, a consolidation step, wherein a consolidation treatment is applied; —optionally, a densification step, wherein a high temperature, high pressure treatment is applied: wherein the % NMVS in the metallic part of the component after the forming step is above 6% and wherein the percentage of reduction of NMVS in the metallic part of the component after the densification step is above 2.6%.[89]A method to manufacture a component comprising the following steps: —providing a metallic powder or metal comprising powder mixture; —a forming step, wherein an additive manufacturing method is applied to form the component, wherein the additive manufacturing method is selected from: selective laser sintering (SLS), selective laser melting (SLM), direct metal laser melting (DMLS), Joule printing, electron beam melting (EBM), direct energy deposition (DeD) and big area additive manufacturing (BAAM): —a fixing step, wherein the oxygen level of the metallic part of the component is set to more than 0.2 ppm and less than 390 ppm and the nitrogen level of the metallic part of the component is set to more than 0.06 ppm and less than 99 ppm: —a consolidation step, wherein a consolidation treatment is applied; wherein the mean pressure applied is at least 0.001 bar and less than 790 bar; wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the maximum pressure applied is between 160 bar and 1800 bar and wherein the maximum temperature is between 0.45*Tm and 0.88*Tm, being Tm the melting temperature of the metallic powder with the lowest melting point in the powder mixture; wherein the % NMVS in the metallic part of the component after the forming step is above 0.2% and below 29%%; wherein the percentage of reduction of NMVS in the metallic part of the component after the consolidation step is above 2.1% and wherein the percentage of increase of the apparent density of the metallic part of the component after the consolidation step is below 29%.[90]A method to manufacture a component comprising the following steps: —providing a metallic powder or metal comprising powder mixture; —applying additive manufacturing method to form the component, wherein the additive manufacturing method is binder jetting (BJ) and wherein the binder jetting (BJ) process temperature is below the reference temperature; —a consolidation step, wherein a consolidation treatment is applied; and —optionally, a densification step, wherein a high temperature, high pressure treatment is applied; wherein the % NMVS in the metallic part of the component after the forming step is above 51% and below 99.98%; wherein the apparent density of the metallic part of the component after the forming step is higher than 31% and less than 99.8%; wherein the percentage of increase of the apparent density of the metallic part of the component after the consolidation step is below 29% and wherein the percentage of reduction of NMVS in the metallic part of the component after the consolidation step is above 26%.[91]A method to manufacture a component comprising the following steps: —providing a metallic powder or metal comprising powder mixture; —applying additive manufacturing method, wherein the additive manufacturing method is binder jetting (BJ) and wherein the binder jetting (BJ) mean printing temperature is below 0.5*Tm, being Tm the melting temperature of the metallic powder with the lowest melting point in the powder mixture; —applying a debinding to eliminate at least part of the binder; —a consolidation step, wherein a consolidation treatment is applied; and —a densification step, wherein a high temperature, high pressure treatment is applied: wherein the % NMVS in the metallic part of the component after the forming step is above 6% and below 99.98%; wherein the apparent density of the metallic part of the component after the forming step is higher than 31% and less than 99.8%; wherein the % NMVC in the metallic part of the component after the consolidation step is above 0.02% and below 0.9% and wherein the percentage of increase of the apparent density of the metallic part of the component after the consolidation step is above 6% and below 69%.[92]A method to manufacture a component comprising the following steps: —providing a metallic powder or metal comprising powder mixture: —a forming step, wherein an additive manufacturing method is applied to form the component, wherein the additive manufacturing method is multi jet fusion (MJF) and wherein the multi jet fusion (MJF) maximum temperature is below 0.46*Tm, being Tm the melting temperature of the metallic powder with the lowest melting point in the powder mixture, which is at least 0.06 wt % of the powder mixture: —a consolidation step, wherein a consolidation treatment is applied; and —optionally, a densification step, wherein a high temperature, high pressure treatment is applied; wherein the % NMVC in the metallic part of the component after the forming step is above 6.2% and below 49%; wherein the apparent density of the metallic part of the component after the forming step is higher than 41% and less than 89.8% and wherein the percentage of increase of the apparent density of the metallic part of the component after the consolidation step is below 19%.[93]A method to manufacture a component comprising the following steps: —providing a metallic powder or metal comprising powder mixture; —a forming step, wherein an additive manufacturing method is applied to form the component, wherein the additive manufacturing method is multi jet fusion (MJF) and wherein the multi jet fusion (MJF) maximum temperature is below 0.46*Tm, being Tm the melting temperature of the metallic powder with the lowest melting point in the powder mixture, which is at least 0.06 wt % of the powder mixture: —a consolidation step, wherein a consolidation treatment is applied; and —optionally, a densification step, wherein a high temperature, high pressure treatment is applied: wherein the % NMVS in the metallic part of the component after the forming step is above 31% and below 98%; wherein the apparent density of the metallic part of the component after the forming step is higher than 41% and less than 89.8% and wherein the percentage of increase of the apparent density of the metallic part of the component after the consolidation step is above 11% and below 59%.[94]A method to manufacture a component comprising the following steps: —providing a metallic powder or metal comprising powder mixture; —a forming step, wherein an additive manufacturing method is applied to form the component, wherein the additive manufacturing method is fused deposition (FDM), and wherein the filament employed in the fused deposition (FDM) comprises a mixture of an organic material and the metallic powder or metal comprising powder mixture; —a consolidation step, wherein a consolidation treatment is applied; and —optionally, a densification step, wherein a high temperature, high pressure treatment is applied; wherein the % NMVS in the metallic part of the component after the consolidation step is above 0.06% and below 24%; wherein the percentage of reduction of NMVS in the metallic part of the component after the consolidation step is above 2.1% and wherein the percentage of increase of the apparent density of the metallic part of the component after the consolidation step is below 29%.[95]A method to manufacture a component comprising the following steps: —providing a powder or powder mixture; —a forming step, wherein an additive manufacturing method is applied to form the component, wherein the additive manufacturing method is fused deposition (FDM) and wherein the filament employed in the fused deposition (FDM) comprises a mixture of an organic material and the powder or powder mixture; —a consolidation step, wherein a consolidation treatment is applied: and —a densification step, wherein a high temperature, high pressure treatment is applied: wherein the percentage of reduction of NMVS in the metallic part of the component after the consolidation step is above 2.1% and wherein the percentage of increase of the apparent density of the metallic part of the component after the consolidation step is below above 11% and below 69%.[96]A method to manufacture a component comprising the following steps: —providing a metallic powder or metal comprising powder mixture; —a forming step, wherein an additive manufacturing method is applied to form the component, wherein the additive manufacturing method is selective laser sintering (SLS), wherein the material employed in the selective laser sintering (SLS) comprises a mixture of polymeric particles and the metallic powder or metal comprising powder mixture; —a consolidation step, wherein a consolidation treatment is applied; and —optionally, a densification step, wherein a high temperature, high pressure treatment is applied; wherein the % NMVS in the metallic part of the component after the forming step is above 31%; wherein the percentage of reduction of NMVS in the metallic part of the component after the consolidation step is above 51% and wherein the percentage of increase of the apparent density of the metallic part of the component after the consolidation step is below 9%.[97]A method to manufacture a component comprising the following steps: —providing a metallic powder or metal comprising powder mixture: —a forming step, wherein an additive manufacturing method is applied to form the component, wherein the additive manufacturing method is fused deposition (FDM): wherein the filament employed in the fused deposition (FDM) comprises a mixture of an organic material and the metallic powder or metal comprising powder mixture and wherein the fused deposition (FDM) maximum temperature is below 0.64*Tm, being Tm the melting temperature of the metallic powder with the lowest melting point in the powder mixture, which is at least 2.6 wt % of the powder mixture; —a consolidation step, wherein a consolidation treatment is applied; and —optionally, a densification step, wherein a high temperature, high pressure treatment is applied; wherein the % NMVS in the metallic part of the component after the forming step is above 51%; wherein the percentage of reduction of NMVS in the metallic part of the component after the consolidation step is above 51% and wherein the percentage of increase of the apparent density of the metallic part of the component after the consolidation step is below 29%,[98]A method to manufacture a component comprising the following steps: —providing a metallic powder or metal comprising powder mixture with an oxygen content of more than 620 ppm and less than 9000 ppm and a nitrogen content of less than 9000 ppm; —a forming step, wherein an additive manufacturing method is applied to form the component, wherein the additive manufacturing method is Binder Jetting (BJ): —a fixing step, wherein the oxygen level of the metallic part of the component is set to less than 140 ppm and the nitrogen level of the metallic part of the component is set to more than 0.06 ppm; —a consolidation step, wherein a consolidation treatment is applied; and —optionally, a densification step, wherein a high temperature, high pressure treatment is applied; wherein the % NMVS in the metallic part of the component after the forming step is above 31%: wherein the percentage of reduction of NMVS in the metallic part of the component after the consolidation step is above 26%; wherein the apparent density of the metallic part of the component after the consolidation step is less than 93.9% and wherein the percentage of increase of the apparent density of the metallic part of the component after the consolidation step is above 6% and below 59%.[99]A method to manufacture a component comprising the following steps: —providing a metallic powder or metal comprising powder mixture: —a forming step, wherein an additive manufacturing method is applied to form the component, wherein the additive manufacturing method is big area additive manufacturing (BAAM) and wherein the big area additive manufacturing (BAAM) mean shaping temperature is above 0.59*Tm, being Tm the melting temperature of the metallic powder with the lowest melting point in the powder mixture which is at least 1.2 wt % of the powder mixture: —a consolidation step, wherein a consolidation treatment is applied; and —optionally, a densification step, wherein a high temperature, high pressure treatment is applied: wherein the % NMVS in the metallic part of the component after the forming step is above 0.02% and below 9%; wherein the apparent density of the metallic part of the component after the forming step is higher than 71% and loss than 99.98% and wherein the percentage of increase of the apparent density of the metallic part of the component after the consolidation step is below 19%.[100]A method to manufacture a component comprising the following steps: —providing a metallic powder or metal comprising powder mixture; —a forming step, wherein an additive manufacturing method is applied to form the component, wherein the additive manufacturing method is big area additive manufacturing (BAAM); wherein the filament employed in the big area additive manufacturing (BAAM) comprises a mixture of an organic material and the metallic powder or metal comprising powder mixture and wherein the big area additive manufacturing (BAAM) mean shaping temperature is below 0.5*Tm, being Tm the melting temperature of the metallic powder with the lowest melting point in the powder mixture; —a consolidation step, wherein a consolidation treatment is applied; and —optionally, a densification step, wherein a high temperature, high pressure treatment is applied; wherein the % NMVS in the metallic part of the component after the forming step is above 31% and below 98%; wherein the apparent density of the metallic part of the component after the forming step is higher than 31% and less than 99.8% and wherein the percentage of increase of the apparent density of the metallic part of the component after the consolidation step is below 29%.[101]A method to manufacture a component comprising the following steps: —providing a metallic powder or metal comprising powder mixture with an oxygen content of more than 250 ppm and less than 4900 ppm and a nitrogen content of more than 12 ppm and less than 900 ppm; —a forming step, wherein an additive manufacturing method is applied to form the component, wherein the additive manufacturing method is direct energy deposition (DeD) and wherein the direct energy deposition (DeD) maximum temperature is above 0.64*Tm, being Tm the melting temperature of the metallic powder with the lowest melting point in the powder mixture; —a fixing step, wherein the oxygen level of the metallic part of the component is set to more than 1.2 ppm and less than 90 ppm and the nitrogen level of the metallic part of the component is set to more than 1.2 ppm and less than 49 ppm; and —optionally, a consolidation step, wherein a consolidation treatment is applied; —optionally, a densification step, wherein a high temperature, high pressure treatment is applied; wherein the apparent density of the metallic part of the component after the forming step is higher than 86% and less than 99.98%; wherein the % NMVS in the metallic part of the component after the forming step is above 0.02% and below 9% and wherein the percentage of reduction of NMVS in the metallic part of the component after the densification step is above 0.02%.[102]A method to manufacture a component comprising the following steps: —providing a metallic powder or metal comprising powder mixture; —a forming step, wherein an additive manufacturing method is applied to form the component, wherein the additive manufacturing method is selective laser melting (SLM) and wherein the selective laser melting (SLM) maximum temperature is above 0.36*Tm, being Tm the melting temperature of the metallic powder with the lowest melting point in the powder mixture; —a fixing step, wherein the oxygen level of the metallic part of the component is set to more than 6 ppm and less than 90 ppm and the nitrogen level of the metallic part of the component is set to more than 0.06 ppm and less than 19 ppm; and at least one of: —a consolidation step, wherein a consolidation treatment is applied; —a densification step, wherein a high temperature, high pressure treatment is applied: wherein the fixing step and the consolidation step and/or the fixing step and the densification step are performed simultaneously; wherein the % NMVS in the metallic part of the component after the forming step is above 6% and wherein the percentage of reduction of NMVS in the metallic part of the component after the densification step is above 2.6%.[103]A method to manufacture a component comprising the following steps: —providing a metallic powder or metal comprising powder mixture; —applying additive manufacturing method to form the component, wherein the additive manufacturing method is binder jetting (BJ); —applying a debinding to eliminate at least part of the binder; —a consolidation step, wherein a consolidation treatment is applied; and —optionally, a densification step, wherein a high temperature, high pressure treatment is applied; wherein the % NMVC in the metallic part of the component after the forming step is above 0.3% and below 64%; wherein the apparent density of the metallic part of the component after the forming step is higher than 31% and less than 79.8%; wherein the % NMVC in the metallic part of the component after the consolidation step is above 0.002% and below 0.9% and wherein the apparent density of the metallic part of the component after the consolidation step is higher than 81% and less than 98.9%.[10⁴]A method to manufacture a component comprising the following steps: —providing a metallic powder or metal comprising powder mixture; —applying additive manufacturing method to form the component, wherein the additive manufacturing method is binder jetting (BJ); —applying a debinding to eliminate at least part of the binder; —a consolidation step, wherein a consolidation treatment is applied; and —optionally, a densification step, wherein a high temperature, high pressure treatment is applied; wherein the % NMVC in the metallic part of the component after the forming step is above 0.3% and below 64%: wherein the apparent density of the metallic part of the component after the forming step is higher than 31% and less than 79.8%; wherein the % NMVC in the metallic part of the component after the consolidation step is above 0.002% and below 0.9%; wherein the apparent density of the metallic part of the component after the consolidation step is higher than 81% and less than 98.9%; and wherein the volume of the component is more than 2% and loss than 89% of the volume of the rectangular cuboid with the minimum possible volume which contains the component.[105]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —applying additive manufacturing method to form the component, wherein the additive manufacturing method is binder jetting (BJ); —a fixing step, wherein the oxygen level of the metallic part of the component is set to more than 0.02 ppm and less than 390 ppm and the nitrogen level of the metallic part of the component is set to more than 0.01 ppm and less than 99 ppm: —a consolidation step, wherein a consolidation treatment is applied; and —optionally, a densification step, wherein a high temperature, high pressure treatment is applied; wherein the % NMVC in the metallic part of the component after the forming step is above 1.2% and below 64%; wherein the apparent density of the metallic part of the component after the forming step is higher than 31% and less than 99.8%; wherein the % NMVS in the metallic part of the component after the consolidation step is above 0.06% and below 39%; wherein the % NMVC in the metallic part of the component after the consolidation step is above 0.002% and below 0.4% and wherein the percentage of increase of the apparent density of the metallic part of the component after the consolidation step is below 29%.[106]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —applying additive manufacturing method to form the component, wherein the additive manufacturing method is binder jetting (BJ): —a debinding step, wherein at least part of the binder is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; and —a densification step, wherein a high temperature, high pressure treatment is applied; wherein the % NMVC in the metallic part of the component after the forming step is above 0.3% and below 64%; wherein the apparent density of the metallic part of the component after the forming step is higher than 41% and less than 89.8%; wherein the % NMVC in the metallic part of the component after the consolidation step is above 0.02% and below 0.9%: wherein the apparent density of the metallic part of the component after the consolidation step is higher than 86% and less than 99.4% and wherein the percentage of increase of the apparent density of the metallic part of the component after the consolidation step is above 11% and below 69%.[107]A method to manufacture a component comprising the following steps: —providing a metallic powder or metal comprising powder mixture with an oxygen content of more than 250 ppm and less than 9000 ppm and a nitrogen content of more than 12 ppm and less than 900 ppm: —applying additive manufacturing method to form the component, wherein the additive manufacturing method is binder jetting (BJ): —a debinding step, wherein at least part of the binder is eliminated; —a fixing step, wherein the oxygen level of the metallic part of the component is set to more than 0.02 ppm and less than 140 ppm and the nitrogen level of the metallic part of the component to more than 0.01 ppm and less than 49 ppm; —a consolidation step, wherein a consolidation treatment is applied; and —optionally, a densification step, wherein a high temperature, high pressure treatment is applied; wherein the % NMVS in the metallic part of the component after the forming step is above 51% and below 99.98%; wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4%: wherein the percentage of increase of the apparent density of the metallic part of the component after the consolidation step is below 29% and wherein the percentage of reduction of NMVS in the metallic part of the component after the consolidation step is above 26%.[108]A method to manufacture a component comprising the following steps: —providing a metallic powder or metal comprising powder mixture; —applying additive manufacturing method to form the component, wherein the additive manufacturing method is fused deposition (FDM), and wherein the filament employed in the fused deposition (FDM) comprises a mixture of an organic material and the metallic powder or metal comprising powder mixture; —applying a debinding to eliminate at least part of the organic material; —a consolidation step, wherein a consolidation treatment is applied; and —optionally, a densification step, wherein a high temperature, high pressure treatment is applied: wherein the % NMVC in the metallic part of the component after the forming step is above 0.3% and below 64%: wherein the apparent density of the metallic part of the component after the forming step is higher than 31% and loss than 79.8%; wherein the % NMVC in the metallic part of the component after the consolidation step is above 0.002% and below 0.9% and wherein the apparent density of the metallic part of the component after the consolidation step is higher than 81% and less than 98.9%.[109]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —applying additive manufacturing method to form the component, wherein the additive manufacturing method is fused deposition (FDM), and wherein the filament employed in the fused deposition (FDM) comprises a mixture of an organic material and the metallic powder or metal comprising powder mixture; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; and —a densification step, wherein a high temperature, high pressure treatment is applied; wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4% and wherein the percentage of increase of the apparent density of the metallic part of the component after the consolidation step is below 29%.[110]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —applying additive manufacturing method to form the component, wherein the additive manufacturing method is fused deposition (FDM), and wherein the filament employed in the fused deposition (FDM) comprises a mixture of an organic material and the metallic powder or metal comprising powder mixture; —applying a debinding to eliminate at least part of the organic material; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; and —optionally, a densification step, wherein a high temperature, high pressure treatment is applied; wherein the % NMVC in the metallic part of the component after the forming step is above 0.3% and below 64%; wherein the apparent density of the metallic part of the component after the forming step is higher than 41% and less than 89.8%: wherein the % NMVC in the metallic part of the component after the consolidation step is above 0.02% and below 0.9%; wherein the % NMVS in the metallic part of the component after the consolidation step is above 0.06% and below 39%; wherein the apparent density of the metallic part of the component after the consolidation step is higher than 86% and less than 99.4% and wherein the percentage of increase of the apparent density of the metallic part of the component after the consolidation step is above 11% and below 69%.[111]A method to manufacture a component comprising the following steps: —providing a metallic powder or metal comprising powder mixture with an oxygen content of more than 250 ppm and less than 9000 ppm and a nitrogen content of more than 12 ppm and less than 900 ppm; —applying additive manufacturing method to form the component, wherein the additive manufacturing method is fused deposition (FDM), and wherein the filament employed in the fused deposition (FDM) comprises a mixture of an organic material and the metallic powder or metal comprising powder mixture; —applying a debinding to eliminate at least part of the organic material: —a fixing step, wherein the oxygen level of the metallic part of the component is set to more than 0.02 ppm and less than 140 ppm and the nitrogen level of the metallic part of the component is set to more than 0.01 ppm and less than 49 ppm; —a consolidation step, wherein a consolidation treatment is applied; and —optionally, a densification step, wherein a high temperature, high pressure treatment is applied; wherein the % NMVS in the metallic part of the component after the forming step is above 51% and below 99.98%; wherein the % NMVC in the metallic part of the component after the forming step is above 1.2% and below 64%; wherein the apparent density of the metallic part of the component after the forming step is higher than 31% and less than 99.8%: wherein the % NMVC in the metallic part of the component after the consolidation step is above 0.002% and below 0.4%; wherein the percentage of increase of the apparent density of the metallic part of the component after the consolidation step is below 29% and wherein the percentage of reduction of NMVS in the metallic part of the component after the consolidation step is above 26%.[112]A method to manufacture a component comprising the following steps: —providing a metallic powder or metal comprising powder mixture; —a forming step, wherein an additive manufacturing method is applied to form the component, wherein the additive manufacturing method is big area additive manufacturing (BAAM); wherein the filament employed in the big area additive manufacturing (BAAM) comprises a mixture of an organic material and the metallic powder or metal comprising powder mixture and wherein the big area additive manufacturing (BAAM) mean shaping temperature is below 0.5*Tm, being Tm the melting temperature of the metallic powder with the lowest melting point in the powder mixture; —applying a debinding to eliminate at least part of the organic material; —a consolidation step, wherein a consolidation treatment is applied; and —optionally, a densification step, wherein a high temperature, high pressure treatment is applied: wherein the % NMVC in the metallic part of the component after the forming step is above 0.3% and below 64%; wherein the apparent density of the metallic part of the component after the forming step is higher than 31% and less than 79.8%; wherein the % NMVC in the metallic part of the component after the consolidation step is above 0.002% and below 0.9% and wherein the apparent density of the metallic part of the component after the consolidation step is higher than 81% and less than 98.9%.[113]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm: —a forming step, wherein an additive manufacturing method is applied to form the component, wherein the additive manufacturing method is big area additive manufacturing (BAAM); wherein the filament employed in the big area additive manufacturing (BAAM) comprises a mixture of an organic material and the metallic powder or metal comprising powder mixture and wherein the big area additive manufacturing (BAAM) mean shaping temperature is below 0.5*Tm, being Tm the melting temperature of the metallic powder with the lowest melting point in the powder mixture; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; and —optionally, a densification step, wherein a high temperature, high pressure treatment is applied; wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4%; wherein the % NMVS in the metallic part of the component after the consolidation step is above 0.06% and below 39% and wherein the percentage of increase of the apparent density of the metallic part of the component after the consolidation step is below 29%.[114]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —a forming step, wherein an additive manufacturing method is applied to form the component, wherein the additive manufacturing method is big area additive manufacturing (BAAM); wherein the filament employed in the big area additive manufacturing (BAAM) comprises a mixture of an organic material and the metallic powder or metal comprising powder mixture and wherein the big area additive manufacturing (BAAM) mean shaping temperature is below 0.5*Tm, being Tm the melting temperature of the metallic powder with the lowest melting point in the powder mixture; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; and —optionally, a densification step, wherein a high temperature, high pressure treatment is applied: wherein the % NMVC in the metallic part of the component after the forming step is above 1.2% and below 64%; wherein the apparent density of the metallic part of the component after the forming stop is higher than 31% and less than 99.8%; wherein the % NMVC in the metallic part of the component after the consolidation step is above 0.002% and below 0.4%; wherein the % NMVS in the metallic part of the component after the consolidation step is above 0.06% and below 39%; wherein the percentage of increase of the apparent density of the metallic part of the component after the consolidation step is below 29%: and wherein the volume of the component is more than 6% and less than 89% of the volume of the rectangular cuboid with the minimum possible volume which contains the component.[115]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm: —applying additive manufacturing method to form the component, wherein the additive manufacturing method is big area additive manufacturing (BAAM); wherein the filament employed in the big area additive manufacturing (BAAM) comprises a mixture of an organic material and the metallic powder or metal comprising powder mixture and wherein the big area additive manufacturing (BAAM) mean shaping temperature is below 0.59*Tm, being Tm the melting temperature of the metallic powder with the lowest melting point in the powder mixture; —applying a debinding to eliminate at least part of the organic material; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; and —optionally, a densification step, wherein a high temperature, high pressure treatment is applied; wherein the % NMVC in the metallic part of the component after the forming step is above 0.3% and below 64%; wherein the apparent density of the metallic part of the component after the forming step is higher than 41% and less than 89.8%; wherein the % NMVC in the metallic part of the component after the consolidation step is above 0.02% and below 0.9%; wherein the apparent density of the metallic part of the component after the consolidation step is higher than 86% and less than 99.4% and wherein the percentage of increase of the apparent density of the metallic part of the component after the consolidation step is above 11% and below 69%.[116]A method to manufacture a component comprising the following steps: —providing a metallic powder or metal comprising powder mixture with an oxygen content of more than 250 ppm and less than 9000 ppm and a nitrogen content of more than 12 ppm and less than 900 ppm: —applying additive manufacturing method, wherein the additive manufacturing method is wherein the additive manufacturing method is big area additive manufacturing (BAAM); wherein the filament employed in the big area additive manufacturing (BAAM) comprises a mixture of an organic material and the metallic powder or metal comprising powder mixture and wherein the big area additive manufacturing (BAAM) mean shaping temperature is below 0.64*Tm, being Tm the melting temperature of the metallic powder with the lowest melting point in the powder mixture; —applying a debinding to eliminate at least part of the organic material; —a fixing step, wherein the oxygen level of the metallic part of the component is set to more than 0.02 ppm and less than 140 ppm and the nitrogen level of the metallic part of the component is set to more than 0.01 ppm and less than 49 ppm; —a consolidation step, wherein a consolidation treatment is applied: and —a densification step, wherein a high temperature, high pressure treatment is applied; wherein the % NMVS in the metallic part of the component after the forming step is above 51% and below 99.98%; wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4%; wherein the percentage of increase of the apparent density of the metallic part of the component after the consolidation step is below 29% and wherein the percentage of reduction of NMVS in the metallic part of the component after the consolidation step is above 26%.[117]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —a forming step, wherein an additive manufacturing method is applied to form the component; —a fixing step, wherein the oxygen level of the metallic part of the component is set to more than 0.02 ppm and less than 390 ppm and the nitrogen level of the metallic part of the component is set to more than 0.01 ppm and less than 99 ppm: —a consolidation step, wherein a consolidation treatment is applied; wherein the mean pressure applied is at least 1.6 bar and less than 790 bar and wherein the maximum temperature is between 0.36*Tm and 0.88*Tm, being Tm the melting temperature of the metallic powder with the lowest melting point in the powder mixture: and —a densification step, wherein a high temperature, high pressure treatment is applied: wherein the mean cross-section of the component is 0.79 times or less the area of the largest rectangular face of the rectangular cuboid with the minimum possible volume which contains the component: wherein the % NMVS in the metallic part of the component after the forming step is above 31% and below 99.8%, and the % NMVS in the metallic part of the component after the consolidation step is above 0.02% and below 39%.[118]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —a forming step, wherein an additive manufacturing method is applied to form the component: —a fixing step, wherein the oxygen level of the metallic part of the component is set to more than 0.2 ppm and less than 390 ppm and the nitrogen level of the metallic part of the component to more than 0.06 ppm and less than 49 ppm; —a consolidation step, wherein a consolidation treatment is applied; and —a densification step, wherein a high temperature, high pressure treatment is applied, wherein the maximum pressure applied is between 160 bar and 4900 bar and wherein the maximum temperature is between 0.45*Tm and 0.92*Tm, being Tm the melting temperature of the metallic powder with the lowest melting point in the powder mixture; wherein the % NMVC in the metallic part of the component after the forming step is above 3.2% and below 24%, and the % NMVC in the metallic part of the component after the consolidation step is below 14%, wherein the apparent density of the metallic part of the component after the forming step is higher than 41% and less than 89.8%; wherein the apparent density of the metallic part of the component after the consolidation step is less than 89% and wherein the apparent density of the metallic part of the component after the densification step is higher than 96%.[119]A method to manufacture a component comprising the following steps: —providing a metallic powder or metal comprising powder mixture; —a forming step, wherein an additive manufacturing method is applied to form the component, wherein the additive manufacturing method comprises the use of a polymer and/or binder: —a consolidation step, wherein a consolidation treatment is applied; wherein the mean pressure applied is at least 0.001 bar, but less than 89 bar and wherein the mean temperature is between 0.54*Tm and 0.92*Tm, being Tm the melting temperature of the metallic powder with the lowest melting point in the powder mixture; and —optionally a densification step, wherein a high temperature, high pressure treatment is applied; wherein the pressure applied is between 320 bar and 2200 bar and wherein the temperature is between 0.55*Tm and 0.92*Tm, being Tm the melting temperature of the metallic powder with the lowest melting point in the powder mixture; wherein the % NMVS in the metallic part of the component after the forming step is above 6% and below 99.98%; wherein the apparent density after the forming step is higher than 31% and less than 99.8%, and wherein the percentage of increase of the apparent density of the metallic part of the component after the consolidation step is below 29%.[120]A method to manufacture a component comprising the following steps: —providing a metallic powder or metal comprising powder mixture: —a forming step, wherein an additive manufacturing method is applied to form the component, wherein the mean temperature employed in the additive manufacturing method is above 0.5*Tm, being Tm the melting temperature of the metallic powder with the lowest melting point in the powder mixture; —a consolidation step, wherein a consolidation treatment is applied; wherein the mean pressure applied is at least 0.01 bar and less than 4900 bar; wherein the maximum temperature is between Tm and 1.49*Tm, being Tm the melting temperature of the metallic powder with the lowest melting point in the powder mixture and wherein the maximum liquid phase during the consolidation step is maintained below 29 vol %; and —optionally, a densification step, wherein a high temperature, high pressure treatment is applied; wherein the mean pressure applied is between 160 bar and 2800 bar and wherein the maximum temperature is between 0.45*Tm and 0.88*Tm, being Tm the melting temperature of the metallic powder with the lowest melting point in the powder mixture; wherein the % NMVS in the metallic part of the component after the forming step is above 0.02% and below 9%; wherein the apparent density after the forming step is higher than 51% and less than 99.98% and wherein the percentage of increase of the apparent density of the metallic part of the component after the consolidation step is below 29%,[121]A method to manufacture a component comprising the following steps: —providing a metallic powder or metal comprising powder mixture; —a forming step, wherein an additive manufacturing method is applied to form the component; —a consolidation step, wherein a consolidation treatment is applied; wherein the mean pressure applied is at least 0.01 bar and less than 4900 bar and wherein the maximum temperature is between 0.54*Tm and 0.96*Tm, being Tm the melting temperature of the metallic powder with the lowest melting point in the powder mixture; and —optionally, a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the % NMVS in the metallic part of the component after the forming step is above 6% and below 99.8%; wherein the apparent density of the metallic part of the component after the forming step is higher than 41% and less than 99.98%; wherein the percentage of increase of the apparent density of the metallic part of the component after the consolidation step is below 19% and wherein the largest cross-section of the component is more than 0.2 mm² and less than 49% of the area of the largest rectangular face of the rectangular cuboid with the minimum possible volume which contains the component, wherein the cross-sections of the component are each of the minimum cross-sections of the component calculated from each cubic voxel with an edge length of 0.009 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel.[122]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —a forming step, wherein an additive manufacturing method is applied to form the component, wherein the additive manufacturing method comprises the use of an organic material; —applying a debinding to eliminate at least part of the organic material; —a fixing step, wherein the oxygen level of the metallic part of the component is set to more than 0.02 ppm and less than 140 ppm and the nitrogen level of the metallic part of the component is set to more than 0.01 ppm and less than 99 ppm; —a consolidation step, wherein a consolidation treatment is applied; wherein the mean pressure applied is at least 0.001 bar, but less than 89 bar and wherein the mean temperature is between 0.54*Tm and 0.92*Tm, being Tm the melting temperature of the metallic powder with the lowest melting point in the powder mixture; and —optionally, a densification step, wherein a high temperature, high pressure treatment is applied; wherein the pressure applied is between 320 bar and 2200 bar and wherein the temperature is between 0.55*Tm and 0.92*Tm, being Tm the melting temperature of the metallic powder with the lowest melting point in the powder mixture; wherein the % NMVC in the metallic part of the component after the forming step is above 0.3% and below 64%; wherein the higher of the metallic part of the component after the forming step is higher than 31% and less than 79.8%; wherein the % NMVC in the metallic part of the component after the consolidation step is above 0.002% and below 0.9% and wherein the apparent density of the metallic part of the component after the consolidation step is higher than 81% and less than 98.9%.[123]A method to manufacture a component comprising the following steps: —providing a metallic powder or metal comprising powder mixture with an oxygen content of more than 620 ppm and less than 9000 ppm and a nitrogen content of less than 9000 ppm; —a forming step, wherein an additive manufacturing method is applied to form the component, wherein the additive manufacturing method comprises the use of an organic material; —applying a debinding to eliminate at least part of the organic material; —a fixing step, wherein the oxygen level of the metallic part of the component is set to less than 140 ppm and the nitrogen level of the metallic part of the component is set to more than 0.06 ppm; —a consolidation step, wherein a consolidation treatment is applied; wherein the mean pressure applied is at least 0.01 bar and less than 4900 bar and wherein the maximum temperature is between 0.54*Tm and 0.96*Tm, being Tm the melting temperature of the metallic powder with the lowest melting point in the powder mixture; and —optionally, a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the % NMVS in the metallic part of the component after the forming step is above 51% and below 99.98%; wherein the % NMVC in the metallic part of the component after the forming step is above 0.3% and below 64%; wherein the higher of the metallic part of the component after the forming step is higher than 31% and less than 99.8%; wherein the percentage of reduction of NMVS in the metallic part of the component after the consolidation step is above 26%, wherein the % NMVC in the metallic part of the component after the consolidation step is above 0.002% and below 4% and wherein the apparent density of the metallic part of the component after the consolidation step is higher than 86% and less than 99.8%.[124]A method to manufacture a component comprising the following steps: —providing a metallic powder or metal comprising powder mixture with an oxygen content of more than 620 ppm and less than 9000 ppm and a nitrogen content of less than 9000 ppm; —a forming step, wherein an additive manufacturing method is applied to form the component, wherein the additive manufacturing method comprises the use of an organic material; —applying a debinding to eliminate at least part of the organic material; —a fixing step, wherein the oxygen level of the metallic part of the component is set to less than 140 ppm and the nitrogen level of the metallic part of the component is set to more than 0.06 ppm; —a consolidation step, wherein a consolidation treatment is applied; wherein the mean pressure applied is at least 0.01 bar and less than 4900 bar and wherein the maximum temperature is between 0.54*Tm and 0.96*Tm, being Tm the melting temperature of the metallic powder with the lowest melting point in the powder mixture; and —optionally, a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the % NMVS in the metallic part of the component after the forming step is above 51% and below 99.98%; wherein the % NMVC in the metallic part of the component after the forming step is above 0.3% and below 64%; wherein the higher of the metallic part of the component after the forming step is higher than 31% and less than 99.8%; wherein the percentage of reduction of NMVS in the metallic part of the component after the consolidation step is above 26%, wherein the % NMVC in the metallic part of the component after the consolidation step is above 0.002% and below 4%: wherein the apparent density of the metallic part of the component after the consolidation step is higher than 86% and less than 99.8%; and wherein the volume of the component is more than 6% and less than 89% of the volume of the rectangular cuboid with the minimum possible volume which contains the component.[125]A method to manufacture a component comprising the following steps: —providing a metallic powder or metal comprising powder mixture; —a forming step, wherein an additive manufacturing method is applied to form the component; —a fixing step, wherein the oxygen level of the metallic part of the component is set to more than 260 ppm and less than 19000 ppm —a consolidation step, wherein a consolidation treatment is applied; and —optionally, a densification step, wherein a high temperature, high pressure treatment is applied; wherein the fixing step comprises the use of an % Oz comprising atmosphere with an % O₂ between 0.002 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O S KYS*(% Y+1.98*% Sc+2.47*% Ti+0.67*% REE), being KYS=2100.[126]A method to manufacture a component comprising the following steps: —providing a metallic powder or metal comprising powder mixture; —a forming step, wherein an additive manufacturing method is applied to form the component; —a fixing step, wherein the oxygen level of the metallic part of the component is set to more than 260 ppm and less than 19000 ppm —a consolidation step, wherein a consolidation treatment is applied; and —optionally, a densification step, wherein a high temperature, high pressure treatment is applied; wherein the fixing step comprises the use of an % O₂ comprising atmosphere with an % O₂ between 0.02 vol % and 89 vol % or less, at a temperature higher than 105° C. and lower than 890° C. which is applied for at least 1 h. but less than 90 h: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98*% Sc+0.67*% REE), being KYS=2350.[127]A method to manufacture a component comprising the following steps: —providing a metallic powder or metal comprising powder mixture: —a forming step, wherein an additive manufacturing method is applied to form the component; —a fixing step, wherein the oxygen level of the metallic part of the component is set to more than 260 ppm and less than 19000 ppm —a consolidation step, wherein a consolidation treatment is applied; and —optionally, a densification step, wherein a high temperature, high pressure treatment is applied; wherein the fixing step comprises the use of an % O₂ comprising atmosphere with an % O₂ between 0.02 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9%: wherein the % O in the component complies with the formula % O≤KYS*(% Y+1.98*% Sc+0.67*% REE), being KYS=2350: and wherein the volume of the component is more than 6% and less than 89% of the volume of the rectangular cuboid with the minimum possible volume which contains the component.[128]A method to manufacture a component comprising the following steps: —providing a metallic powder or metal comprising powder mixture with an oxygen content which is higher than 410 ppm and lower than 14000 ppm; —a forming step, wherein an additive manufacturing method is applied to form the component; —a fixing step, wherein the oxygen level of the metallic part of the component is set to more than 260 ppm and less than 19000 ppm —a consolidation step, wherein a consolidation treatment is applied; and —optionally, a densification step, wherein a high temperature, high pressure treatment is applied: wherein the fixing step comprises the use of an % O₂ comprising atmosphere with an % O₂ between 0.002 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26% and wherein the % NMVC in the metallic part of the component after the consolidation step is above 0.002% and below 0.9%.[129]A method to manufacture a component comprising the following steps: —providing a metallic powder or metal comprising powder mixture with an oxygen content which is higher than 410 ppm and lower than 14000 ppm: —a forming step, wherein an additive manufacturing method is applied to form the component, wherein the additive manufacturing method comprises the use of an organic material; —applying a debinding to eliminate at least part of the organic material: —a fixing step, wherein the oxygen level of the metallic part of the component is set to more than 260 ppm and less than 14000 ppm; —a consolidation step, wherein a consolidation treatment is applied: wherein the mean pressure applied is at least 0.01 bar, but less than 4900 bar and wherein the maximum temperature is between 0.46*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.45*Tm and 0.92*Tm, being Tm the melting temperature of the metallic powder with the lowest melting point in the powder mixture; wherein the fixing step comprises the use of an % O₂ comprising atmosphere, with an % Oz between 0.002 vol % and 49 vol % or less, at a temperature higher than 105° C. and lower than 890° C. which is applied for at least 1 h, but less than 90 h; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[130]A method to manufacture a component comprising the following steps: —providing a metallic powder or metal comprising powder mixture comprising a % Yeq(1) content which is higher than 0.03 wt % and lower than 8.9 wt %; —a forming step, wherein an additive manufacturing method is applied to form the component; —a fixing step, wherein the nitrogen level of the metallic part of the component is set between 0.02 wt % and 3.9 wt %: —a consolidation step, wherein a consolidation treatment is applied; and —optionally, a densification step, wherein a high temperature, high pressure treatment is applied.[131]A method to manufacture a component comprising the following steps: —providing a metallic powder or metal comprising powder mixture; wherein a nitrogen comprising material is admixed in the powder o powder mixture; wherein the amount of nitrogen comprising material is selected so as to have between 0.22 wt % and 2.9 wt % nitrogen; —a forming step, wherein an additive manufacturing method is applied to form the component; —a fixing step, wherein the nitrogen level of the metallic part of the component is set between 0.02 wt % and 2.9 wt %; —a consolidation step, wherein a consolidation treatment is applied; and, —optionally, a densification step, wherein a high temperature, high pressure treatment is applied; [132]A method to manufacture a component comprising the following steps: —providing a metallic powder or metal comprising powder mixture comprising a % Yeq(1) content which is higher than 0.03 wt % and lower than 8.9 wt %; —a forming step, wherein an additive manufacturing method is applied to form the component, wherein the additive manufacturing method comprises the use of an organic material; —applying a debinding to eliminate at least part of the organic material; —a fixing step, wherein the nitrogen level of the metallic part of the component is set between 0.2 wt % and 3.9 wt %; —a consolidation step, wherein a consolidation treatment is applied; and —optionally, a densification step, wherein a high temperature, high pressure treatment is applied; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26% and wherein the % NMVC in the metallic part of the component after the consolidation step is above 0.002% and below 0.9%.[133]A method to manufacture a component comprising the following steps: —providing a metallic powder or metal comprising powder mixture; —a forming step, wherein an additive manufacturing method is applied to form the component; —a fixing step, wherein the nitrogen level of the metallic part of the component is set between 0.02 wt % and 2.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% k and wherein the % Yeq(1) content in the component is higher than 0.03 wt % and lower than 8.9 wt %.[134]A method to manufacture a component comprising the following steps: —providing a metallic powder or metal comprising powder mixture; —a forming step, wherein an additive manufacturing method is applied to form the component; —a debinding step; —applying a pressure and/or temperature treatment; —a fixing step, wherein the nitrogen level of the metallic part of the component is set between 0.02 wt % and 2.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the % Yeq(1) content in the component is higher than 0.03 wt % and lower than 8.9 wt %.[135]A method to manufacture a component comprising the following steps: —providing a metallic powder or metal comprising powder mixture; —a forming step, wherein an additive manufacturing method is applied to form the component, wherein the additive manufacturing method comprises the use of an organic material; —applying a debinding to eliminate at least part of the organic material: —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the % Yeq(1) content in the component is higher than 0.03 wt % and lower than 8.9 wt %.[136]A method to manufacture a component comprising the following steps: —providing a metallic powder or metal comprising powder mixture comprising a nitrogen austenitic steel in powdered form; —a forming step, wherein an additive manufacturing method is applied to form the component: —a fixing step, wherein the nitrogen level of the metallic part of the component is set between 0.02 wt % and 2.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 0.78 mol % and 15.21 mol % and a temperature which is above 655° C. and below 14400° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[137]A method to manufacture a component comprising the following steps: —providing a metallic powder or metal comprising powder mixture comprising a nitrogen austenitic steel in powdered form; —a forming step, wherein an additive manufacturing method is applied to form the component, wherein the additive manufacturing method comprises the use of an organic material; —applying a debinding to eliminate at least part of the organic material; —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%: wherein the % NMVC in the metallic part of the component after the forming step is above 0.3% and below 64%; wherein the higher of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[138]A method to manufacture a component comprising the following steps: —providing a metallic powder or metal comprising powder mixture comprising a nitrogen austenitic steel in powdered form; —a forming step, wherein an additive manufacturing method is applied to form the component, wherein the additive manufacturing method comprises the use of an organic material; —applying a debinding to eliminate at least part of the organic material; —applying a pressure and/or temperature treatment; —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%: wherein the % NMVC in the metallic part of the component after the forming step is above 0.3% and below 64%; wherein the higher of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[139]A method to manufacture a component comprising the following steps: —providing a metallic powder or metal comprising powder mixture: —a forming step, wherein an additive manufacturing method is applied to form the component; —a fixing step, wherein the nitrogen level of the metallic part of the component is set between 0.02 wt % and 2.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%; wherein the component has the composition of a nitrogen austenitic steel.[140]A method to manufacture a component comprising the following steps: —providing a metallic powder or metal comprising powder mixture; —a forming step, wherein an additive manufacturing method is applied to form the component, wherein the additive manufacturing method comprises the use of an organic material; —applying a debinding to eliminate at least part of the organic material; —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%; wherein the component has the composition of a nitrogen austenitic steel.[141]A method to manufacture a component comprising the following steps: —providing a metallic powder or metal comprising powder mixture; —a forming step, wherein an additive manufacturing method is applied to form the component; —a fixing step, wherein the nitrogen level of the metallic part of the component is set between 0.02 wt % and 3.9 wt %; —a consolidation step, wherein a consolidation treatment is applied; and —optionally, a densification step, wherein a high temperature, high pressure treatment is applied; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the component comprises at least one material with the composition of a nitrogen austenitic steel.[142]A method to manufacture a component comprising the following steps: —providing a metallic powder or metal comprising powder mixture; —a forming step, wherein an additive manufacturing method is applied to form the component, wherein the additive manufacturing method comprises the use of an organic material; —applying a debinding to eliminate at least part of the organic material; —applying a pressure and/or temperature treatment: —a fixing step, wherein the nitrogen level of the metallic part of the component is set between 0.02 wt % and 3.9 wt %; —a consolidation step, wherein a consolidation treatment is applied; and —optionally, a densification step, wherein a high temperature, high pressure treatment is applied; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the component comprises at least one material with the composition of a nitrogen austenitic steel.[143]A method to manufacture a component comprising the following steps: —providing a metallic powder or metal comprising powder mixture, with a content of % V+% Al+% Cr+% Mo+% Ta+% W+% Nb between 0.12 wt % and 34 wt %; —a forming step, wherein an additive manufacturing method is applied to form the component: —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture: and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%: wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[144]A method to manufacture a component comprising the following steps: —providing a metallic powder or metal comprising powder mixture with a content of % V+% Al+% Cr+% Mo+% Ta+% W+% Nb between 0.12 wt % and 34 wt %; —a forming step, wherein an additive manufacturing method is applied to form the component, wherein the additive manufacturing method comprises the use of an organic material; —applying a debinding to eliminate at least part of the organic material; —a fixing step, wherein the nitrogen level of the metallic part of the component is set between 0.02 wt % and 3.9 wt %; —a consolidation step, wherein a consolidation treatment is applied: wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%; wherein the higher of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[145]A method to manufacture a component comprising the following steps: —providing a metallic powder or metal comprising powder mixture: —a forming step, wherein an additive manufacturing method is applied to form the component; —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%; wherein the higher of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the content of % V+% Al+% Cr+% Mo+% Ta+% W+% Nb in the component is between 0.12 wt % and 34 wt %.[146]A method to manufacture a component comprising the following steps: —providing a metallic powder or metal comprising powder mixture; —a forming step, wherein an additive manufacturing method is applied to form the component, wherein the additive manufacturing method comprises the use of an organic material; —applying a debinding to eliminate at least part of the organic material; —applying a pressure and/or temperature treatment; —a fixing step, wherein the nitrogen level of the metallic part of the component is set between 0.02 wt % and 3.9 wt %; —a consolidation step, wherein a consolidation treatment is applied: wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%: wherein the apparent density of the metallic part of the component after the densification step is higher than 98.2% and wherein the content of % V+% Al+% Cr+% Mo+% Ta+% W+% Nb in the component comprises a between 0.12 wt % and 34 wt %.[147]A method to manufacture a component comprising the following steps: —providing a metallic powder or metal comprising powder mixture; —a forming step, wherein an additive manufacturing method is applied to form the component, wherein the additive manufacturing method comprises the use of an organic material; —a consolidation step, wherein a consolidation treatment is applied; and —a densification step, wherein a high temperature, high pressure treatment is applied; wherein the consolidation step comprises the application of a vacuum with an absolute pressure between 0.9*10⁻² mbar and 0.9*10⁻¹² mbar.[148]A method to manufacture a component comprising the following steps: —providing a powder or powder mixture; —a forming step, wherein an additive manufacturing method is applied to form the component; —a fixing step, wherein the oxygen and/or nitrogen level of the metallic part of the component is set; —a consolidation step, wherein a consolidation treatment is applied; and —a densification step, wherein a high temperature, high pressure treatment is applied; wherein the consolidation step comprises the application of a vacuum with an absolute pressure between 0.9*10⁻³ mbar and 0.9*10⁻¹² mbar.[149]A method to manufacture a component comprising the following steps: —providing a powder or powder mixture; —a forming step, wherein an additive manufacturing method is applied to form the component; —a debinding step; —a fixing step, wherein the oxygen and/or nitrogen level of the metallic part of the component is set; —a consolidation step, wherein a consolidation treatment is applied; and —a densification step, wherein a high temperature, high pressure treatment is applied; wherein the consolidation step comprises the application of a vacuum with an absolute pressure between 0.9*10⁻³ mbar and 0.9*10⁻¹² mbar.[150]A method to manufacture a component comprising the following steps: —providing a metallic powder or metal comprising powder mixture; —a forming step, wherein an additive manufacturing method is applied to form the component, wherein the additive manufacturing method comprises the use of an organic material; —a consolidation step, wherein a consolidation treatment is applied; and —a densification step, wherein a high temperature, high pressure treatment is applied; wherein the consolidation step comprises the application of a vacuum with an absolute pressure between 0.9*10⁻³ mbar and 0.9*10⁻¹² mbar; wherein the % NMVS in the metallic part of the component after the forming step is above 0.02% and below 99.8%; wherein the % NMVC in the metallic part of the component after the forming step is above 0.3% and below 64%; wherein the % NMVS in the metallic part of the component after the consolidation step is above 0.02% and below 39% and wherein the % NMVC in the metallic part of the component after the consolidation step is above 0.002% and below 9%.[151]A method to manufacture a component comprising the following steps: —providing a powder or powder mixture; —a forming step, wherein an additive manufacturing method is applied to form the component: —a debinding step: —a fixing step, wherein the oxygen and/or nitrogen level of the metallic part of the component is set; —a consolidation step, wherein a consolidation treatment is applied; and —a densification step, wherein a high temperature, high pressure treatment is applied; wherein the consolidation step comprises the application of a vacuum with an absolute pressure between 0.9*10⁻² mbar and 0.9*10⁻¹² mbar: wherein the % NMVS in the metallic part of the component after the forming step is above 0.2% and below 99.8%; wherein the % NMVC in the metallic part of the component after the forming step is above 0.3% and below 49%; wherein the % NMVS in the metallic part of the component after the consolidation step is above 0.06% and below 39% and wherein the % NMVC in the metallic part of the component after the consolidation step is above 0.006% and below 9%.[152]A method to manufacture a component comprising the following steps: —providing a metallic powder or metal comprising powder mixture; —a forming step, wherein an additive manufacturing method is applied to form the component; —a fixing step, wherein the oxygen level of the metallic part of the component is set to more than 260 ppm and less than 19000 ppm; —a consolidation step, wherein a consolidation treatment is applied; and —optionally, a densification step, wherein a high temperature, high pressure treatment is applied; wherein the consolidation step comprises the use of an % O₂ comprising atmosphere with an % O₂ between 0.002 vol % and 89 vol % or less, at a temperature higher than 105° C. and lower than 890° C. which is applied for at least 1 h, but less than 90 h: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98*% Sc+2.47-% Ti+0.67*% REE), being KYS=2100.[153]A method to manufacture a component comprising the following steps: —providing a metallic powder or metal comprising powder mixture; —a forming step, wherein an additive manufacturing method is applied to form the component; —a fixing step, wherein the oxygen level of the metallic part of the component is set to more than 260 ppm and less than 19000 ppm; —a consolidation step, wherein a consolidation treatment is applied; and —optionally, a densification step, wherein a high temperature, high pressure treatment is applied; wherein the fixing step and the consolidation step comprises the use of an % O₂ comprising atmosphere with an % O₂ between 0.02 vol % and 89 vol % or less, at a temperature higher than 105° C. and lower than 890° C. which is applied for at least 1 h, but less than 90 h: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%: wherein the % NMVC in the metallic part of the component after the consolidation step is above 0.002% and below 0.9% and wherein the % O in the component complies with the formula % O≤KYS*(% Y+1.98*% Sc+0.67*% REE), being KYS=2350.[154]A method to manufacture a component comprising the following steps: —providing a metallic powder or metal comprising powder mixture: —a forming step, wherein an additive manufacturing method is applied to form the component; —a debinding step; —applying a pressure and/or temperature treatment; —a fixing step, wherein the oxygen level of the metallic part of the component is set to more than 260 ppm and less than 19000 ppm: —a consolidation step, wherein a consolidation treatment is applied; and —optionally, a densification step, wherein a high temperature, high pressure treatment is applied: wherein the fixing step and the consolidation step comprises the use of an % O₂ comprising atmosphere with an % O₂ between 0.02 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%: wherein the % NMVC in the metallic part of the component after the consolidation step is above 0.002% and below 0.9% and wherein the % O in the component complies with the formula 0 s KYS*(% Y+1.98*% Sc+0.67*% REE), being KYS=2350.[155]A method to manufacture a component comprising the following steps: —providing a metallic powder or metal comprising powder mixture with an oxygen content which is higher than 410 ppm and lower than 14000 ppm; —a forming step, wherein an additive manufacturing method is applied to form the component; —a fixing step, wherein the oxygen level of the metallic part of the component is set to more than 260 ppm and less than 19000 ppm; —a consolidation step, wherein a consolidation treatment is applied; and —optionally, a densification step, wherein a high temperature, high pressure treatment is applied; wherein the consolidation step comprises the use of an % O₂ comprising atmosphere, with an % O₂ between 0.002 vol % and 89 vol % or less, at a temperature higher than 105° C. and lower than 890° C. which is applied for at least 1 h. but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26% and wherein the % NMVC in the metallic part of the component after the consolidation step is above 0.002% and below 0.9%.[156]A method to manufacture a component comprising the following steps: —providing a metallic powder or metal comprising powder mixture comprising a % Yeq(1) content which is higher than 0.03 wt % and lower than 8.9 wt %; —a forming step, wherein an additive manufacturing method is applied to form the component; —a fixing step, wherein the nitrogen level of the metallic part of the component is set between 0.02 wt % and 2.9 wt %; —a consolidation step, wherein a consolidation treatment is applied; and —optionally, a densification step, wherein a high temperature, high pressure treatment is applied; wherein the fixing step and the consolidation step comprise the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26% and wherein the % NMVC in the metallic part of the component after the consolidation step is above 0.002% and below 0.9%.[157]A method to manufacture a component comprising the following steps: —providing a metallic powder or metal comprising powder mixture; —a forming step, wherein an additive manufacturing method is applied to form the component; —a fixing step, wherein the nitrogen level of the metallic part of the component is set between 0.02 wt % and 2.9 wt %: —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the consolidation step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is more than 98.2% and wherein the % Yeq(1) content in the component is higher than 0.03 wt % and lower than 8.9 wt %[158]A method to manufacture a component comprising the following steps: —providing a metallic powder or metal comprising powder mixture comprising a nitrogen austenitic steel in powdered form; —a forming step, wherein an additive manufacturing method is applied to form the component: —a fixing step, wherein the nitrogen level of the metallic part of the component is set between 0.2 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture: wherein the consolidation step comprises the use of an atmosphere with an atomic nitrogen content between 0.78 mol % and 15.21 mol % and a temperature which is above 655° C. and below 1440° C.: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%: wherein the % NMVC in the metallic part of the component after the consolidation step is above 0.002% and below 0.9% and wherein the apparent density of the metallic part of the component after the densification step is higher than 98.2%.[159]A method to manufacture a component comprising the following steps: —providing a metallic powder or metal comprising powder mixture; —a forming step, wherein an additive manufacturing method is applied to form the component; —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the fixing step and the consolidation step comprise the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9%: wherein the apparent density of the metallic part of the component after the densification step is higher than 98.2% and wherein the component has the composition of a nitrogen austenitic steel.[160]A method to manufacture a component comprising the following steps: —providing a metallic powder or metal comprising powder mixture; —a forming step, wherein an additive manufacturing method is applied to form the component; —applying a debinding; —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture: wherein the fixing step and the consolidation step comprise the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9%%; wherein the apparent density of the metallic part of the component after the densification step is higher than 98.2%; wherein the component has the composition of a nitrogen austenitic steel and wherein the volume of the component is more than 2% and less than 89% of the volume of the rectangular cuboid with the minimum possible volume which contains the component.[161]A method to manufacture a component comprising the following steps: —providing a metallic powder or metal comprising powder mixture; —a forming step, wherein an additive manufacturing method is applied to form the component, wherein the additive manufacturing method comprises the use of an organic material; —applying a debinding to eliminate at least part of the organic material; —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture: and —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the consolidation step comprises the use of an atmosphere with an atomic nitrogen content between 0.78 mol % and 15.21 mol % and a temperature which is above 655° C. and below 1440° C.: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the component comprises at least one material with the composition of a nitrogen austenitic steel.[162]A method to manufacture a component comprising the following steps: —providing a metallic powder or metal comprising powder mixture with a content of % V+% Al+% Cr+% Mo+% Ta+% W+% Nb between 0.12 wt % and 34 wt %: —a forming step, wherein an additive manufacturing method is applied to form the component, wherein the additive manufacturing method comprises the use of an organic material; —applying a debinding to eliminate at least part of the organic material: —a fixing step, wherein the nitrogen level of the metallic part of the component is set between 0.2 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; and —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; wherein the consolidation step comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[163]A method to manufacture a component comprising the following steps: —providing a metallic powder or metal comprising powder mixture; —a forming step, wherein an additive manufacturing method is applied to form the component; —a fixing step, wherein the nitrogen level of the metallic part of the component is set between 0.02 wt % and 3.9 wt %; —a consolidation step, wherein a consolidation treatment is applied; wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture: and —a densification step, wherein a high temperature, high pressure treatment is applied: wherein the mean pressure applied is between 160 bar and 2800 bar and wherein the maximum temperature is between 0.55*Tm and 0.92*Tm, being Tm the molting temperature of the metallic powder with the lowest molting point in the powder mixture; wherein the fixing step and the consolidation step comprise the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%; wherein the content of % V+% Al+% Cr+% Mo+% Ta+% W+% Nb in the component is between 0.12 wt % and 34 wt %.[164]A method to manufacture a component comprising the following steps: —providing a powder or powder mixture; —a forming step, wherein an additive manufacturing method is applied to form the component; —a debinding step: —a consolidation step, wherein a consolidation treatment is applied; and —optionally, a densification step, wherein a high temperature, high pressure treatment is applied; wherein the component comprises fine channels with a H value greater than 12 and less than 1098, being H=the total length of the fine channels/the mean length of the fine channels; wherein the equivalent diameter of the fine channels is between 0.1 mm to 128 mm; wherein the number of fine channels per square meter of thermo-regulated surface is between 21 and 14000: wherein the fluid flows in the fine channels in such a way that the mean Reynolds number is maintained greater than 810 and less than 89000; wherein the component comprises at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C.[165]A method to manufacture a component comprising the following steps: —providing a metallic powder or metal comprising powder mixture; —a forming step, wherein an additive manufacturing method is applied to form the component; —applying a pressure and/or temperature treatment; —a debinding step; —a fixing step, wherein the oxygen and/or nitrogen level of the metallic part of the component is set: —a consolidation step, wherein a consolidation treatment is applied; and —optionally, a densification step, wherein a high temperature, high pressure treatment is applied; wherein the component comprises fine channels and main channels; wherein the mean cross-section of the main channels is at least 6 times higher than the cross-section of the smallest channel among all the fine channels in the component area where the thermo-regulation is desired; wherein the distance from the fine channels to the surface to be thermo-regulated is between 0.6 mm and 32 mm; wherein the equivalent diameter of the fine channels is between 0.1 mm to 128 mm; wherein the number of fine channels per square meter of thermo-regulated surface is between 21 and 14000; wherein the fluid flows in the fine channels in such a way that the mean Reynolds number is maintained greater than 810 and less than 89000; wherein the rugosity of the channels is between 0.9 microns and 190 microns; wherein the component comprises at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C.[166]A method to manufacture a component comprising the following steps: —providing a metallic powder or metal comprising powder mixture: —a forming step, wherein an additive manufacturing method is applied to form the component; —applying a pressure and/or temperature treatment; —a debinding step: —applying a pressure and/or temperature treatment; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied; wherein the component comprises comprising fine channels, wherein the distance from the fine channels to the surface to be thermo-regulated is between 0.6 mm and 32 mm; wherein the equivalent diameter of the fine channels is between 0.1 mm to 128 mm; wherein the number of fine channels per square meter of thermo-regulated surface is between 21 and 14000; wherein the fluid flows in the fine channels in such a way that the mean Reynolds number is maintained greater than 810 and less than 89000 and wherein the rugosity of the channels is at least 0.9 microns and less than 190 microns.[167]A method to manufacture a component comprising the following steps: —providing a metallic powder or metal comprising powder mixture with an oxygen content of more than 250 ppm and less than 19000 ppm and a nitrogen content of more than 12 ppm and less than 9000 ppm; —applying additive manufacturing method to form the component; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; and —optionally, a densification step, wherein a high temperature, high pressure treatment is applied; wherein the % NMVC in the metallic part of the component after the forming step is above 1.2% and below 64%: wherein the apparent density of the metallic part of the component after the forming step is higher than 31% and less than 99.8%; wherein the % NMVS in the metallic part of the component after the consolidation step is above 0.06% and below 39%; wherein the % NMVC in the metallic part of the component after the consolidation step is above 0.002% and below 0.4%; wherein the percentage of increase of the apparent density of the metallic part of the component after the consolidation step is below 29% and wherein the component comprises fine channels with an equivalent diameter between 0.1 mm and 128 mm and at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C. and less than 199° C.[168]A method to manufacture a component comprising the following steps: —providing a metallic powder or metal comprising powder mixture; —a forming step, wherein an additive manufacturing method is applied to form the component; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied: wherein the volume of the component is more than 2% and less than 89% of the volume of a rectangular cuboid with the minimum possible volume which contains the component and wherein the component comprises fine channels; and main channels; wherein the cross-section of the main channels is at least 3 times higher than the cross-section of the smallest channel among all the fine channels in the component area where the thermo-regulation is desired; wherein the distance from the fine channels to the surface to be thermo-regulated is between 1.2 mm and 19 mm: wherein the equivalent diameter of the fine channels is between 1.2 mm and 18 mm; wherein the number of fine channels per square meter of thermo-regulated surface is between 61 and 4000; wherein the fluid flows in the fine channels in such a way that the mean Reynolds number is maintained greater than 2800 and less than 26000: wherein the rugosity of the channels is at least 10.2 microns and less than 98 microns; wherein the component comprises at least one inlet collector and one outlet collector connected by more than one fine channel with a temperature gradient within the collector below 9° C. and wherein the temperature gradient between the two insertion points of the fine channels to the collectors, for the 20% of the fine channels whose temperature gradients between their two insertion points are greater, is more than 2.6° C.[169]The method according to any of [1] to [168], wherein the additive manufacturing method comprises the use of an organic material and the debinding step is applied to eliminate at least part of the organic material of the additively manufactured component.[170]The method according to any of [1] to [169], wherein the additive manufacturing method comprises the use of an organic material and the debinding step is applied to eliminate at least part of the organic material of the component obtained after the pressure and/or temperature treatment.[171]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder; —a debinding step, wherein at least part of the polymer and/or binder is eliminated; —a consolidation step, wherein a consolidation treatment is applied to achieve a right apparent density: —a densification step, wherein a high temperature, high pressure treatment is applied; and —optionally, applying a heat treatment and/or machining.[172]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder: —applying a debinding to eliminate at least part of the polymer and/or binder: —a fixing step, wherein the oxygen and/or nitrogen level of the metallic part of the component is set; —a consolidation step, wherein a consolidation treatment is applied: —a densification step, wherein a high temperature, high pressure treatment is applied; and —optionally, applying a heat treatment and/or machining.[173]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder; —applying a pressure and/or temperature treatment: —a debinding step, wherein at least part of the polymer and/or binder is eliminated; —applying a pressure and/or temperature treatment; —a consolidation step, wherein a consolidation treatment is applied; —a densification step, wherein a high temperature, high pressure treatment is applied; and —optionally, applying a heat treatment and/or machining.[174]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder; —a debinding step, wherein at least part of the polymer and/or binder is eliminated; —applying a pressure and/or temperature treatment; —a consolidation step, wherein a consolidation treatment is applied; and —optionally, a densification step, wherein a high temperature, high pressure treatment is applied; —optionally, applying a heat treatment and/or machining.[175]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder; —applying a pressure and/or temperature treatment; —a debinding step, wherein at least part of the polymer and/or binder is eliminated: —a fixing step, wherein the oxygen and/or nitrogen level of the metallic part of the component is set; —a consolidation step, wherein a consolidation treatment is applied; and —optionally, a densification step, wherein a high temperature, high pressure treatment is applied; —optionally, applying a heat treatment and/or machining.[176]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder; —applying a pressure and/or temperature treatment; —a fixing step, wherein the oxygen and/or nitrogen level of the metallic part of the component is set; —a consolidation step, wherein a consolidation treatment is applied: and —optionally, a densification step, wherein a high temperature, high pressure treatment is applied; —optionally, applying a heat treatment and/or machining.[177]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder; —a debinding step, wherein at least part of the polymer and/or binder is eliminated; —applying a pressure and/or temperature treatment; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining.[178]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder; —applying a pressure and/or temperature treatment: —a debinding step, wherein at least part of the polymer and/or binder is eliminated; —applying a pressure and/or temperature treatment: —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining.[179]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder; —applying a pressure and/or temperature treatment; —a debinding step, wherein at least part of the polymer and/or binder is eliminated; —applying a pressure and/or temperature treatment; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied; —optionally, applying a heat treatment and/or machining.[180]A method for manufacturing at least part of a metal comprising component, which method comprises the following steps: —providing a powder or powder mixture comprising at least a metal or a metal alloy in powdered form: —a forming step, wherein the component from the powder or powder mixture comprising at least a metal or a metal alloy in powdered form using a metal additive manufacturing (MAM) method is formed, wherein the MAM method comprises the use of a polymer and/or binder; —a debinding step, wherein at least part of the polymer and/or binder is eliminated; —optionally, a fixing step, wherein the oxygen and/or nitrogen level of the metallic part of the component is set; —optionally, applying a pressure and/or temperature treatment; —optionally, a consolidation step, wherein a consolidation treatment is applied; —optionally, a densification step, wherein a high temperature, high pressure treatment is applied; —optionally, applying a heat treatment and/or machining.[181]A method for manufacturing at least part of a metal comprising component, which method comprises the following steps: —providing a powder or powder mixture comprising at least a metal or a metal alloy in powdered form; —a forming step, wherein the component from the powder or powder mixture comprising at least a metal or a metal alloy in powdered form using a metal additive manufacturing (MAM) method is formed, wherein the MAM method comprises the use of a polymer and/or binder: —optionally, applying a debinding to eliminate at least part of the polymer and/or binder: —optionally, a fixing step, wherein the oxygen and/or nitrogen level of the metallic part of the component is set; —optionally, applying a pressure and/or temperature treatment; —optionally, a consolidation step, wherein a consolidation treatment is applied; —optionally, a densification step, wherein a high temperature, high pressure treatment is applied: —optionally, applying a heat treatment and/or machining.[182]A method for manufacturing at least part of a metal comprising component, which method comprises the following steps: —providing a mold at least partly manufactured by additive manufacturing; —filling the mold with a powder or a powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied to achieve a right apparent density; —a densification step, wherein a high temperature, high pressure treatment is applied; and —optionally, applying a heat treatment and/or machining.[183]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining.[184]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a fixing step, wherein the oxygen and/or nitrogen level of the metallic part of the component is set; —a consolidation step, wherein a consolidation treatment is applied: and —optionally, a densification step, wherein a high temperature, high pressure treatment is applied: —optionally, applying a heat treatment and/or machining.[185]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining.[186]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a consolidation step, wherein a consolidation treatment is applied: —a densification step, wherein a high temperature, high pressure treatment is applied; and —optionally, applying a heat treatment and/or machining,[187]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —applying a pressure and/or temperature treatment; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining.[188]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a densification step, wherein a high temperature, high pressure treatment is applied: and —optionally, applying a heat treatment and/or machining.[189]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold: —a fixing step, wherein the oxygen and/or nitrogen level of the metallic part of the component is set; and —optionally, a densification step, wherein a high temperature, high pressure treatment is applied; —optionally, applying a heat treatment and/or machining.[190]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a fixing step, wherein the oxygen and/or nitrogen level of the metallic part of the component is set; —a densification step, wherein a high temperature, high pressure treatment is applied; and —optionally, applying a heat treatment and/or machining.[191]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a fixing step, wherein the oxygen and/or nitrogen level of the metallic part of the component is set; —a densification step, wherein a high temperature, high pressure treatment is applied; and —optionally, applying a heat treatment and/or machining.[192]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment: —a fixing step, wherein the oxygen and/or nitrogen level of the metallic part of the component is set; —a densification step, wherein a high temperature, high pressure treatment is applied; and —optionally, applying a heat treatment and/or machining.[193]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —applying a pressure and/or temperature treatment; —a fixing step, wherein the oxygen and/or nitrogen level of the metallic part of the component is set; —a consolidation step, wherein a consolidation treatment is applied: —a densification step, wherein a high temperature, high pressure treatment is applied; and —optionally, applying a heat treatment and/or machining.[194]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; and —optionally, a debinding step, wherein at least part of the mold is eliminated: —optionally, applying a pressure and/or temperature treatment; —optionally, a fixing step, wherein the oxygen and/or nitrogen level of the metallic part of the component is set; —optionally, a consolidation step, wherein a consolidation treatment is applied; —optionally, a densification step, wherein a high temperature, high pressure treatment is applied; —optionally, applying a heat treatment and/or machining.[195]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; and —optionally, applying a pressure and/or temperature treatment; —optionally, a fixing step, wherein the oxygen and/or nitrogen level of the metallic part of the component is set; —optionally, a consolidation step, wherein a consolidation treatment is applied; —optionally, a densification step, wherein a high temperature, high pressure treatment is applied: —optionally, applying a heat treatment and/or machining.[196]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 0.02% and below 99.8%.[197]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —applying a pressure and/or temperature treatment; —a densification step, wherein a high temperature, high pressure treatment is applied; and —optionally, applying a heat treatment and/or machining; wherein the percentage of reduction of NMVS in the metallic part of the component after the consolidation step is above 2.1%.[198]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a densification step, wherein a high temperature, high pressure treatment is applied; and —optionally, applying a heat treatment and/or machining; wherein the % NMVS in the metallic part of the component after the forming step is above 6% and wherein the % NMVS in the metallic part of the component after the consolidation step is below 39%[199]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 21% and below 99.8% and wherein the % NMVS in the metallic part of the component after the consolidation step is above 0.02% and below 24%.[200]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining: wherein the % NMVS in the metallic part of the component after the forming step is above 0.02% and below 98%; wherein the % NMVS in the metallic part of the component after the consolidation step is above 0.02% and below 14% and wherein the % NMVS after the densification step is below 9%.[201]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; -forming the component by applying a pressure and/or temperature to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the apparent density of the metallic part of the component after the forming step is less than 89.8%.[202]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a consolidation step, wherein a consolidation treatment is applied; and —optionally, a densification step, wherein a high temperature, high pressure treatment is applied; —optionally, applying a heat treatment and/or machining: wherein the apparent density of the metallic part of the component after the forming step is higher than 21% and less than 99.8%.[203]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated: —a consolidation step, wherein a consolidation treatment is applied; and —applying a pressure and/or temperature treatment: —a densification step, wherein a high temperature, high pressure treatment is applied; wherein the apparent density of the metallic part of the component after the forming step is higher than 31% and wherein the apparent density of the metallic part of the component after the consolidation step is higher than 81%.[204]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a consolidation step, wherein a consolidation treatment is applied; —a densification step, wherein a high temperature, high pressure treatment is applied; and —optionally, applying a heat treatment and/or machining; wherein the apparent density of the metallic part of the component after the forming step is higher than 31% and less than 96.9%; and wherein the apparent density of the metallic part of the component after the densification step is higher than 98.2% and less than 99.98%.[205]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining: wherein the apparent density of the metallic part of the component after the forming step is higher than 31%; wherein the apparent density of the metallic part of the component after the consolidation step is higher than 81% and wherein the apparent density of the metallic part of the component after the densification step is higher than 96%.[206]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —a consolidation step, wherein a consolidation treatment is applied: —a densification step, wherein a high temperature, high pressure treatment is applied; and —optionally, applying a heat treatment and/or machining: wherein the apparent density of the metallic part of the component after the forming step is higher than 21% and less than 89.8%; wherein the apparent density of the metallic part of the component after the consolidation step is higher than 81% and less than 98.9% and wherein the apparent density of the metallic part of the component after the densification step is higher than 98.2% k and less than 99.98%.[207]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; and —applying a pressure and/or temperature treatment: —a densification step, wherein a high temperature, high pressure treatment is applied; and —optionally, applying a heat treatment and/or machining; wherein the % NMVC in the metallic part of the component after the forming step is below 64%.[208]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied: —a densification step, wherein a high temperature, high pressure treatment is applied; and —optionally, applying a heat treatment and/or machining; wherein the % NMVC in the metallic part of the component after the forming step is above 0.3% and below 49%.[209]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated: —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is below 49% and wherein the % NMVC in the metallic part of the component after the consolidation step is below 9%.[210]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a consolidation step, wherein a consolidation treatment is applied; and; —a densification step, wherein a high temperature, high pressure treatment is applied; wherein the % NMVC in the metallic part of the component after the forming step is below 49% and wherein the % NMVC in the metallic part of the component after the consolidation step is below 9%.[211]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —applying a pressure and/or temperature treatment; and —a consolidation step, wherein a consolidation treatment is applied; —optionally, a densification step, wherein a high temperature, high pressure treatment is applied: —optionally, applying a heat treatment and/or machining; wherein the % NMVC in the metallic part of the component after the forming step is above 0.3% and below 64% and wherein the % NMVC in the metallic part of the component after the consolidation step is above 0.002% and below 4%.[212]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —a consolidation step, wherein a consolidation treatment is applied; and; —a densification step, wherein a high temperature, high pressure treatment is applied; wherein the % NMVC in the metallic part of the component after the forming step is above 1.2% and below 49%; wherein the % NMVC in the metallic part of the component after the consolidation step is below 9% and wherein the % NMVC in the metallic part of the component after the densification step is below 1.9%.[213]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the percentage of reduction of NMVS in the metallic part of the component after the consolidation step is above 2.1% and wherein the percentage of increase of the apparent density of the metallic part of the component after the consolidation step is above 11% and below 69%.[214]A method for manufacturing at least part of a metal comprising component comprising the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —a fixing step, wherein the oxygen and/or nitrogen level of the metallic part of the component is set: —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 6% and below 98%; wherein the percentage of reduction of NMVS in the metallic part of the component after the consolidation step is above 6%; wherein the percentage of increase of the apparent density of the metallic part of the component after the consolidation step is above 6% and below 69% and wherein the % NMVS after the densification step is below 19%.[215]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 6% and below 99.98%; wherein the apparent density of the metallic part of the component after the forming step is higher than 31% and less than 99.8%: wherein the % NMVS in the metallic part of the component after the consolidation step is above 0.06% and below 39% and wherein the percentage of increase of the apparent density of the metallic part of the component after the consolidation step is below 29%.[216]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining: wherein the % NMVS in the metallic part of the component after the forming step is above 31% and below 98%; wherein the apparent density of the metallic part of the component after the forming step is higher than 41% and less than 89.8% and wherein the percentage of increase of the apparent density of the metallic part of the component after the consolidation step is below 19%.[217]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated: —applying a pressure and/or temperature treatment: —a consolidation step, wherein a consolidation treatment is applied; —a densification step, wherein a high temperature, high pressure treatment is applied; and —optionally, applying a heat treatment and/or machining: wherein the % NMVS in the metallic part of the component after the forming step is above 51%; wherein the percentage of reduction of NMVS in the metallic part of the component after the consolidation step is above 51% and wherein the percentage of increase of the apparent density of the metallic part of the component after the consolidation step is below 14%.[218]A method for manufacturing at least part of a metal comprising component, which method comprises the following steps: —providing a mold at least partly manufactured by additive manufacturing, wherein the additive manufacturing method is selected from: selective laser sintering (SLS), multi jet fusion (MJF), drop on demand (DOD), stereolithography (SLA), binder jetting (BJ), digital light processing (DLP), continuous digital light processing (CDLP), digital light synthesis (DLS), a technology based on continuous liquid interface production (CLIP), direct energy deposition (DeD), fused deposition (FDM), fused filament fabrication (FFF), selective heat sintering (SHS), and big area additive manufacturing (BAAM); —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a densification step, wherein a high temperature, high pressure treatment is applied; and —optionally, applying a heat treatment and/or machining; wherein the % NMVS in the metallic part of the component after the forming step is above 6% and below 99.98%; wherein the apparent density of the metallic part of the component after the forming step is higher than 31% and less than 99.8%; wherein the % NMVC in the metallic part of the component after the consolidation step is above 0.02% and below 0.9% and wherein the percentage of increase of the apparent density of the metallic part of the component after the consolidation step is above 6% and below 69%.[219]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a densification step, wherein a high temperature, high pressure treatment is applied: and —optionally, applying a heat treatment and/or machining; wherein the % NMVS in the metallic part of the component after the forming step is above 51% and below 99.98%; wherein the apparent density of the metallic part of the component after the forming step is higher than 31% and less than 99.8%: wherein the percentage of increase of the apparent density of the metallic part of the component after the consolidation step is below 29%; wherein the percentage of reduction of NMVS in the metallic part of the component after the consolidation step is above 26% and wherein the percentage of reduction of NMVC in the metallic part of the component after the densification step is above 3.6%.[220]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied: —a densification step, wherein a high temperature, high pressure treatment is applied; and —optionally, applying a heat treatment and/or machining; wherein the % NMVS in the metallic part of the component after the forming step is above 6% and below 99.98%; wherein the apparent density of the metallic part of the component after the forming step is higher than 31% and less than 99.8%; wherein the % NMVC in the metallic part of the component after the consolidation step is above 0.002% and below 0.9% and wherein the percentage of increase of the apparent density of the metallic part of the component after the consolidation step is above 6% and below 69%.[221]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 6.2% and below 49%; wherein the apparent density of the metallic part of the component after the forming step is higher than 41% and less than 89.8% and wherein the percentage of increase of the apparent density of the metallic part of the component after the consolidation step is below 19%.[222]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 31% and below 98%; wherein the apparent density of the metallic part of the component after the forming step is higher than 41% and less than 89.8% and wherein the percentage of increase of the apparent density of the metallic part of the component after the consolidation step is above 11% and below 59%.[223]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —applying a pressure and/or temperature treatment; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the consolidation step is above 0.06% and below 24%: wherein the percentage of reduction of NMVS in the metallic part of the component after the consolidation step is above 2.1% and wherein the percentage of increase of the apparent density of the metallic part of the component after the consolidation step is below 29%.[224]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated: —a consolidation step, wherein a consolidation treatment is applied; and —a densification step, wherein a high temperature, high pressure treatment is applied; —optionally, applying a heat treatment and/or machining; wherein the % NMVS in the metallic part of the component after the forming step is above 31%; wherein the percentage of reduction of NMVS in the metallic part of the component after the consolidation step is above 51% and wherein the percentage of increase of the apparent density of the metallic part of the component after the consolidation step is below 9%.[225]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a consolidation step, wherein a consolidation treatment is applied; —a densification step, wherein a high temperature, high pressure treatment is applied; and —optionally, applying a heat treatment and/or machining: wherein the % NMVS in the metallic part of the component after the forming step is above 51%; wherein the percentage of reduction of NMVS in the metallic part of the component after the consolidation step is above 51% and wherein the percentage of increase of the apparent density of the metallic part of the component after the consolidation step is below 29%.[226]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 31%; wherein the percentage of reduction of NMVS in the metallic part of the component after the consolidation step is above 51% and wherein the percentage of increase of the apparent density of the metallic part of the component after the consolidation step is below 9%.[227]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the consolidation step is above 0.02% and below 24%: wherein the percentage of reduction of NMVS in the metallic part of the component after the consolidation step is above 2.1% and wherein the percentage of increase of the apparent density of the metallic part of the component after the consolidation step is below 29%.[228]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining: wherein the % NMVC in the metallic part of the component after the forming step is above 0.3% and below 64%; wherein the apparent density of the metallic part of the component after the forming step is higher than 31% and less than 99.8%; wherein the % NMVC in the metallic part of the component after the consolidation step is above 0.002% and below 4% and wherein the apparent density of the metallic part of the component after the densification step is higher than 96%. [229]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a fixing step, wherein the oxygen and/or nitrogen level of the metallic part of the component is set: —a consolidation step, wherein a consolidation treatment is applied; and —optionally, a densification step, wherein a high temperature, high pressure treatment is applied; —optionally, applying a heat treatment and/or machining: wherein the % NMVS in the metallic part of the component after the forming step is above 6% and below 99.98%; wherein the % NMVC in the metallic part of the component after the forming step is above 0.3% and below 49%: wherein the apparent density of the metallic part of the component after the forming step is higher than 31% and less than 99.8%; wherein the percentage of reduction of NMVS in the metallic part of the component after the consolidation step is above 2.1% and wherein the % NMVC in the metallic part of the component after the consolidation step is above 0.002% and below 9%.[230]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining; wherein the volume of the component is more than 2% and less than 89% of the volume of the rectangular cuboid with the minimum possible volume which contains the component.[231]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment: —a fixing step, wherein the oxygen and/or nitrogen level of the metallic part of the component is set; —a consolidation step, wherein a consolidation treatment is applied: —a densification step, wherein a high temperature, high pressure treatment is applied; and —optionally, applying a heat treatment and/or machining; wherein the volume of the component is more than 2% and less than 89% of the volume of the rectangular cuboid with the minimum possible volume which contains the component. [232]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining; wherein the volume of the component is more than 2% and less than 89% of the volume of the cuboid shaped with the working surface of the component, wherein the cuboid shaped with the working surface of the component is defined as the rectangular cuboid with the minimum possible volume which contains the component, wherein the face of the rectangular cuboid that is in contact with the working surface of the component is substituted by a face with a geometrical shape that is coincident with the geometrical shape of the working surface of the component and has the minimum possible area,[233]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; and —optionally a densification step, wherein a high temperature, high pressure treatment is applied; wherein the % NMVS in the metallic part of the component after the forming step is above 6% and wherein the volume of the component is more than 2% and less than 74% of the volume of the rectangular cuboid with the minimum possible volume which contains the component.[234]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a consolidation step, wherein a consolidation treatment is applied; and —a densification step, wherein a high temperature, high pressure treatment is applied; wherein the apparent density of the metallic part of the component after the forming step is higher than 31% and less than 99.8%; wherein the apparent density of the metallic part of the component after the consolidation step is higher than 81% and less than 99.8% and wherein the volume of the component is less than 89% of the volume of the rectangular cuboid with the minimum possible volume which contains the component.[235]A method for manufacturing at least part of a metal comprising component, which method comprises the following steps: —providing a mold at least partly manufactured by additive manufacturing, wherein the additive manufacturing method is selected from: selective laser sintering (SLS), multi jet fusion (MJF), drop on demand (DOD), stereolithography (SLA), binder jetting (BJ), digital light processing (DLP), continuous digital light processing (CDLP), digital light synthesis (DLS), a technology based on continuous liquid interface production (CLIP), direct energy deposition (DeD), fused deposition (FDM), fused filament fabrication (FFF), selective heat sintering (SHS), and big area additive manufacturing (BAAM); —filling the mold with a powder or powder mixture comprising at least a metal or a metal alloy in powdered form; —a forming step, wherein the component is formed by applying a pressure and/or temperature treatment to the mold; —a fixing step, wherein the oxygen and/or nitrogen level of the metallic part of the component is set: —a debinding step, wherein at least part of the mold is eliminated; —a densification step, wherein a high temperature, high pressure treatment is applied; and —optionally, applying a heat treatment and/or machining; wherein the apparent density of the metallic part of the component after the forming step is higher than 31% and less than 99.8%; wherein the apparent density of the metallic part of the component after the consolidation step is higher than 81% and less than 99.8% and wherein the volume of the component is less than 74% of the volume of the rectangular cuboid with the minimum possible volume which contains the component.[238]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 55 ppm and less than 900 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to less than 140 ppm and the nitrogen level of the metallic part of the component to less than 49 ppm; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 31%: wherein the percentage of increase of the apparent density of the metallic part of the component after the consolidation step is below 14% and wherein the volume of the component is more than 20% and less than 89% of the volume of the rectangular cuboid with the minimum possible volume which contains the component.[237]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 0.02% and below 99.98%: wherein the % NMVC in the metallic part of the component after the forming step is above 0.3% and below 64%; wherein the apparent density of the metallic part of the component after the forming step is higher than 21% and less than 99.8%: wherein the percentage of reduction of NMVS in the metallic part of the component after the consolidation step is above 2.1%; wherein the % NMVC in the metallic part of the component after the consolidation step is above 0.002% and below 9%; wherein the apparent density of the metallic part of the component after the consolidation step is higher than 81% and wherein the volume of the component is more than 2% and less than 89% of the volume of the rectangular cuboid with the minimum possible volume which contains the component.[238]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a fixing step, wherein the oxygen and/or nitrogen level of the metallic part of the component is set; —a consolidation step, wherein a consolidation treatment is applied: —a densification step, wherein a high temperature, high pressure treatment is applied; and —optionally, applying a heat treatment and/or machining; wherein the % NMVS in the metallic part of the component after the forming step is above 0.02% and below 99.98%; wherein the % NMVC in the metallic part of the component after the forming step is above 0.3% and below 64%; wherein the apparent density of the metallic part of the component after the forming step is higher than 21% and less than 99.8%: wherein the percentage of reduction of NMVS in the metallic part of the component after the consolidation step is above 2.1%; wherein the % NMVC in the metallic part of the component after the consolidation step is above 0.002% and below 9%; wherein the apparent density of the metallic part of the component after the consolidation step is higher than 81% and wherein the volume of the component is more than 2% and less than 89% of the volume of the cuboid shaped with the working surface of the component, wherein the cuboid shaped with the working surface of the component is defined as the rectangular cuboid with the minimum possible volume which contains the component, wherein the face of the rectangular cuboid that is in contact with the working surface of the component is substituted by a face with a geometrical shape that is coincident with the geometrical shape of the working surface of the component and has the minimum possible area.[239]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining: wherein the % NMVC in the metallic part of the component after the forming step is above 0.3% and below 64%; wherein the apparent density of the metallic part of the component after the forming step is higher than 31% and less than 79.8%; wherein the % NMVC in the metallic part of the component after the consolidation step is above 0.002% and below 0.9%; wherein the apparent density of the metallic part of the component after the consolidation step is higher than 81% and less than 98.9%: and wherein the volume of the component is more than 20% and less than 89% of the volume of the rectangular cuboid with the minimum possible volume which contains the component.[240]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm: —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 1.2% and below 64%; wherein the apparent density of the metallic part of the component after the forming step is higher than 31% and less than 99.8%: wherein the % NMVC in the metallic part of the component after the consolidation step is above 0.002% and below 0.4%; wherein the % NMVS in the metallic part of the component after the consolidation step is above 0.06% and below 39%; wherein the percentage of increase of the apparent density of the metallic part of the component after the consolidation step is below 29%; and wherein the volume of the component is more than 6% and less than 89% of the volume of the rectangular cuboid with the minimum possible volume which contains the component. [241]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 620 ppm and less than 9000 ppm and a nitrogen content of less than 9000 ppm —a forming step, wherein the component is formed by applying a pressure and/or temperature treatment to the mold; —a debinding step, wherein at least part of the mold is eliminated: —a densification step, wherein a high temperature, high pressure treatment is applied; and —a fixing step, wherein the oxygen level of the metallic part of the component is set to less than 140 ppm and the nitrogen level of the metallic part of the component is set to more than 0.06 ppm; —a consolidation step, wherein a consolidation treatment is applied, wherein the mean pressure applied is at least 0.01 bar and less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the % NMVS in the metallic part of the component after the forming step is above 51% and below 99.98%; wherein the % NMVC in the metallic part of the component after the forming step is above 0.3% and below 64%: wherein the apparent density of the metallic part of the component after the forming step is higher than 31% and less than 99.8%; wherein the percentage of reduction of NMVS in the metallic part of the component after the consolidation step is above 26%, wherein the % NMVC in the metallic part of the component after the consolidation step is above 0.002% and below 4%; wherein the apparent density of the metallic part of the component after the consolidation step is higher than 86% and less than 99.8%; and wherein the volume of the component is more than 6% and less than 89% of the volume of the rectangular cuboid with the minimum possible volume which contains the component.[242]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with a content of % Al+% Ti+% Y+% Sc+% REE between 0.012 wt % and 6.8 wt %; —a forming step, wherein the component is formed by applying a pressure and/or temperature treatment to the mold; —a debinding step, wherein at least part of the mold is eliminated; —a fixing step, wherein the nitrogen level of the metallic part of the component is set to more than 0.02 wt % and less than 3.9 wt %; —a consolidation step, wherein a consolidation treatment is applied; —a densification step, wherein a high temperature, high pressure treatment is applied; and —optionally, applying a heat treatment and/or machining; wherein the fixing step comprises the use of an atmosphere with an atomic nitrogen content between 2.14 mol % and 89 mol % and wherein the volume of the component is more than 20% and less than 89% of the volume of the rectangular cuboid with the minimum possible volume which contains the component.[243]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content which is higher than 410 ppm and lower than 14000 ppm; —a forming step, wherein the component is formed by applying a pressure and/or temperature treatment to the mold; —a debinding step, wherein at least part of the mold is eliminated: —applying a pressure and/or temperature treatment: —a fixing step, wherein the oxygen level of the metallic part of the component is set to more than 260 ppm and less than 19000 ppm; —a consolidation step, wherein a consolidation treatment is applied; —a densification step, wherein a high temperature, high pressure treatment is applied; and —optionally, applying a heat treatment and/or machining; wherein the consolidation step comprises the use of an % O₂ comprising atmosphere, with an % O₂ between 0.002 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the volume of the component is less than 74% of the volume of the rectangular cuboid with the minimum possible volume which contains the component.[244]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a fixing step, wherein the oxygen level of the metallic part of the component is set to more than 260 ppm and less than 19000 ppm —a consolidation step, wherein a consolidation treatment is applied; —a densification step, wherein a high temperature, high pressure treatment is applied; and —optionally, applying a heat treatment and/or machining; wherein the fixing step comprises the use of an % O₂ comprising atmosphere with an % O₂ between 0.02 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the % O in the component complies with the formula % O≤KYS*(% Y+1.98*% Sc+0.67*% REE), being KYS=2350; and wherein the volume of the component is more than 6% and less than 89% of the volume of the rectangular cuboid with the minimum possible volume which contains the component. [245]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture: —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining: wherein the fixing step and the consolidation step comprise the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2%; wherein the component has the composition of a nitrogen austenitic steel: wherein the volume of the component is more than 2% and less than 89% of the volume of the rectangular cuboid with the minimum possible volume which contains the component.[246]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 620 ppm and loss than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied: —a densification step, wherein a high temperature, high pressure treatment is applied; and —optionally, applying a heat treatment and/or machining; wherein the mean cross-section of the component is 0.79 times or less the area of the largest rectangular face of the rectangular cuboid with the minimum possible volume which contains the component; wherein the % NMVS in the metallic part of the component after the forming step is above 31% and below 99.8% and wherein the % NMVS in the metallic part of the component after the consolidation step is above 0.06% and below 24%.[247]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; with an oxygen content of more than 250 ppm and a nitrogen content of more than 12 ppm —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.2 ppm and less than 140 ppm and the nitrogen level of the metallic part of the component is set to less than 99 ppm; —a consolidation step, wherein a consolidation treatment is applied; —a densification step, wherein a high temperature, high pressure treatment is applied; and —optionally, applying a heat treatment and/or machining; wherein the mean cross-section of the component is more than 0.2 mm² and 0.49 times or less the area of the largest rectangular face of the rectangular cuboid with the minimum possible volume which contains the component: wherein the 20% of the largest cross-sections and the 20% of the smallest cross-sections are not considered to calculate the mean cross-section; wherein the % NMVC in the metallic part of the component after the forming step is above 6.2% and below 49% and wherein the % NMVC in the metallic part of the component after the consolidation step is above 0.002% and below 4%.[248]A method for manufacturing at least part of a metal comprising component, which method comprises the following steps: —providing a mold at least partly manufactured by additive manufacturing: —filling the mold with a powder or a powder mixture comprising at least a metal or a metal alloy in powdered form; —a debinding step, wherein at least part of the mold is eliminated; —a consolidation step, wherein a consolidation treatment is applied to achieve a right apparent density: —a densification step, wherein a high temperature, high pressure treatment is applied; and —optionally, applying a heat treatment and/or machining; wherein the mean cross-section of the component is more than 0.2 mm² and 0.59 times or less the area of the largest rectangular face of the rectangular cuboid with the minimum possible volume which contains the component. [249]A method for manufacturing at least part of a metal comprising component comprising the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a fixing step, wherein the oxygen and/or nitrogen level of the metallic part of the component is set: —a consolidation step, wherein a consolidation treatment is applied; —a densification step, wherein a high temperature, high pressure treatment is applied; and —optionally, applying a heat treatment and/or machining; wherein the largest cross-section of the component is more than 0.2 mm² and less than 2900000 mm²; wherein the largest cross-section of the component is the largest cross section obtained after excluding the 50% of the largest cross-sections.[250]A method for manufacturing at least part of a metal comprising component comprising the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied: and —optionally, applying a heat treatment and/or machining; wherein largest cross-section of the component is more than 0.2 mm² and 0.59 times or less the area of the largest rectangular face of the rectangular cuboid with the minimum possible volume which contains the component and wherein the largest cross-section of the component is the largest cross section obtained after excluding the 40% of the largest cross-sections.[251]A method for manufacturing at least part of a metal comprising component comprising the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining; wherein the mean cross-section of the component is more than 0.2 mm² and less than 2900000 mm², wherein the 20% of the largest cross-sections and the 20% of the smallest cross-sections are not considered to calculate the mean cross-section and wherein the largest thickness of the component is more than 0.12 mm and less than 1900 mm.[252]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a debinding step, wherein at least part of the mold is eliminated; —applying a pressure and/or temperature treatment; —a fixing step, wherein the oxygen level of the metallic part of the component is set to more than 0.02 ppm and less than 390 ppm and/or the nitrogen level of the metallic part of the component is set to more than 0.01 ppm and less than 99 ppm; —a consolidation step, wherein a consolidation treatment is applied; —a densification step, wherein a high temperature, high pressure treatment is applied; and —optionally, applying a heat treatment and/or machining; wherein the mean cross-section of the component is more than 2 mm² and less than 400000 mm²; and wherein the mean cross-section of the component is the mean cross-section obtained when the 20% of the largest cross-sections and the 20% of the smallest cross-sections are not considered to calculate the mean cross-section.[253]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 620 ppm and less than 48000 ppm and a nitrogen content of less than 9000 ppm; —a forming step, wherein the component is formed by applying a pressure and/or temperature treatment to the mold; —a debinding step, wherein at least part of the mold is eliminated; —applying a pressure and/or temperature treatment: —a fixing step, wherein the oxygen level of the metallic part of the component is set to less than 390 ppm and the nitrogen level of the metallic part of the component is set to less than 99 ppm; —a consolidation step, wherein a consolidation treatment is applied; —a densification step, wherein a high temperature, high pressure treatment is applied; and —optionally, applying a heat treatment and/or machining; wherein the largest cross-section of the component is 0.19 times or loss the area of the largest rectangular face of the rectangular cuboid with the minimum possible volume which contains the component and wherein the percentage of reduction of NMVS in the metallic part of the component after the consolidation step is above 6%.[254]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —applying a pressure and/or temperature treatment; —a consolidation step, wherein a consolidation treatment is applied; and —a densification step, wherein a high temperature, high pressure treatment is applied: wherein the apparent density of the metallic part of the component after the forming step is higher than 41% and less than 89.8%; wherein the apparent density of the metallic part of the component after the consolidation step is higher than 81% and less than 98.9%; wherein the apparent density of the metallic part of the component after the densification step is higher than 98.2% and less than 99.98%: wherein the mean cross-section of the component is more than 0.2 mm² and 0.49 times or less the area of the largest rectangular face of the rectangular cuboid with the minimum possible volume which contains the component; wherein the 20% of the largest cross-sections and the 20% of the smallest cross-sections are not considered to calculate the mean cross-section.[255]A method for manufacturing at least part of a metal comprising component, which method comprises the following steps: —providing a mold at least partly manufactured by additive manufacturing; —filling the mold with a powder or a powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a consolidation step, wherein a consolidation treatment is applied to achieve a right apparent density; —a densification step, wherein a high temperature, high pressure treatment is applied; and —optionally, applying a heat treatment and/or machining; wherein the mean cross-section of the component is more than 0.2 mm² and less than 2900000 mm², being the cross-sections of the component each of the minimum cross-sections of the component calculated from each rectangular cubic voxel which is totally comprised in the component, wherein the number of rectangular cuboid voxels comprised in the component is calculated from Vrc-V/n³ being Vrc the volume of the rectangular cubic voxel in m³, V is the volume of the rectangular cuboid in m³ and n³ is the number of rectangular cuboid voxels which are contained in the rectangular cuboid, being n a natural number which is more than 11 and less than 94000, provided that the minimum cross-section of the component associated to each rectangular cubic voxel is the minimum cross-section of the component which comprises the geometrical center of the rectangular cuboid voxel.[256]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and/or the nitrogen level of the metallic part of the component is set to more than 0.01 ppm and less than 99 ppm; —a consolidation step, wherein a consolidation treatment is applied; —a densification step, wherein a high temperature, high pressure treatment is applied; and —optionally, applying a heat treatment and/or machining; wherein the mean cross-section of the component is more than 0.2 mm² and 0.49 times or less the area of the largest rectangular face of the rectangular cuboid with the minimum possible volume which contains the component wherein the 20% of the largest cross-sections and the 20% of the smallest cross-sections are not considered to calculate the mean cross-section; wherein the cross-sections of the component are each of the minimum cross-sections of the component calculated from each cubic voxel with an edge length of 0.09 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel.[257]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and/or the nitrogen level of the metallic part of the component is set to more than 0.01 ppm and less than 99 ppm; —a consolidation step, wherein a consolidation treatment is applied; —a densification step, wherein a high temperature, high pressure treatment is applied; and —optionally, applying a heat treatment and/or machining; wherein the largest cross-section of the component is more than 0.2 mm^{z} and 0.49 times or less the area of the largest rectangular face of the rectangular cuboid with the minimum possible volume which contains the component and is the largest cross-section obtained after excluding the 40% of the largest cross-sections of the component, wherein the cross-sections of the component are each of the minimum cross-sections of the component calculated from each cubic voxel with an edge length of 0.09 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel.[258]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 140 ppm and/or the nitrogen level of the metallic part of the component is set to more than 0.01 ppm and less than 49 ppm; —a consolidation step, wherein a consolidation treatment is applied: —a densification step, wherein a high temperature, high pressure treatment is applied; and —optionally, applying a heat treatment and/or machining; wherein the % NMVS in the metallic part of the component after the forming step is above 31% and below 98%; wherein the % NMVC in the metallic part of the component after the forming step is above 0.3% and below 64%; wherein the percentage of reduction of NMVS in the metallic part of the component after the consolidation step is above 11%; wherein the % NMVC in the metallic part of the component after the consolidation step is above 0.002% and below 4%; wherein the apparent density of the metallic part of the component after the densification step is less than 99.98%; and wherein the mean cross-section of the component is more than 0.2 mm² and less than 2900000 mm².[259]A method for manufacturing at least part of a metal comprising component, which method comprises the following steps: —providing a mold at least partly manufactured by additive manufacturing; —filling the mold with a powder or a powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied to achieve a right apparent density; —a densification step, wherein a high temperature, high pressure treatment is applied; and —optionally, applying a heat treatment and/or machining: wherein the mean cross-section of the component is more than 0.2 mm² and less than 2900000 mm², being the cross-sections of the component each of the minimum cross-sections of the component calculated from each cubic voxel with an edge length of 0.01 mm which is totally comprised in the component, provided that the minimum cross-section of the component associated to each cubic voxel is the minimum cross-section of the component which comprises the geometrical center of the cubic voxel and that there is at least one cubic voxel having a geometrical center which is coincident with the gravity center, considering homogeneous density, of the rectangular cuboid and that the faces of the cubic voxels and the faces of the rectangular cuboid are parallel.[260]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 620 ppm and less than 48000 ppm and a nitrogen content of less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to less than 390 ppm and the nitrogen level of the metallic part of the component is set to less than 99 ppm; —a consolidation step, wherein a consolidation treatment is applied; —a densification step, wherein a high temperature, high pressure treatment is applied; and —optionally, applying a heat treatment and/or machining: wherein the largest cross-section of the component is less than 19% of the area of the largest rectangular face of the rectangular cuboid with the minimum possible volume which contains the component and wherein the percentage of reduction of NMVS in the metallic part of the component after the consolidation step is above 6%[261]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 9000 ppm and a nitrogen content of more than 12 ppm; —a forming step, wherein the component is formed by applying a pressure and/or temperature treatment to the mold; —a debinding step, wherein at least part of the mold is eliminated; —applying a pressure and/or temperature treatment; —a fixing step, wherein the oxygen level of the metallic part of the component is set to more than 0.02 ppm and less than 90 ppm and the nitrogen level of the metallic part of the component is set to more than 0.01 ppm and less than 19 ppm; —a consolidation step, wherein a consolidation treatment is applied; —a densification step, wherein a high temperature, high pressure treatment is applied; and —optionally, applying a heat treatment and/or machining: wherein the mean cross-section of the component is more than 0.2 mm² and less than 2900000 mm², wherein the 20% of the largest cross-sections and the 20% of the smallest cross-sections are not considered to calculate the mean cross-section, being the cross-sections of the component each of the minimum cross-sections of the component calculated from each rectangular cubic voxel which is totally comprised in the component, wherein the number of rectangular cuboid voxels comprised in the component is calculated from Vrc-V/n³ being Vrc the volume of the rectangular cubic voxels in m³, V is the volume of the rectangular cuboid in m³ and n³ is the number of rectangular cuboid voxels which are contained in the rectangular cuboid, being n a natural number which is more than 11 and less than 990000, provided that the minimum cross-section of the component associated to each rectangular cubic voxel is the minimum cross-section of the component which comprises the geometrical center of the rectangular cuboid voxel.[262]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 620 ppm and less than 48000 ppm and a nitrogen content of more than 12 ppm and less than 900 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to less than 390 ppm and the nitrogen level of the metallic part of the component is set to less than 99 ppm; —a consolidation step, wherein a consolidation treatment is applied; —a densification step, wherein a high temperature, high pressure treatment is applied: and —optionally, applying a heat treatment and/or machining; wherein the mean cross-section of the component is more than 0.2 mm² and 0.49 times or less the area of the largest rectangular face of the rectangular cuboid with the minimum possible volume which contains the component; wherein the % NMVC in the metallic part of the component after the forming step is below 49%; wherein the % NMVC in the metallic part of the component after the consolidation step is below 9%; wherein the apparent density of the metallic part of the component after the forming step is higher than 51%; wherein the apparent density of the metallic part of the component after the consolidation step is higher than 81% and wherein the apparent density of the metallic part of the component after the densification step is higher than 96% and less than 99.98%.[263]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated: —applying a pressure and/or temperature treatment; —a fixing step, wherein the oxygen level of the metallic part of the component is set to more than 0.2 ppm and less than 390 ppm and the nitrogen level of the metallic part of the component is set to more than 0.06 ppm and less than 49 ppm: —a consolidation step, wherein a consolidation treatment is applied; —a densification step, wherein a high temperature, high pressure treatment is applied; and —optionally, applying a heat treatment and/or machining; wherein the mean cross-section of the component is more than 0.2 mm² and less than 9000 mm², wherein the 20% of the largest cross-sections and the 20% of the smallest cross-sections are not considered to calculate the mean cross-section, being the cross-sections of the component each of the minimum cross-sections of the component calculated from each rectangular cubic voxel which is totally comprised in the component, wherein the number of rectangular cuboid voxels comprised in the component is calculated from Vrc-V/n³ being Vrc the volume of the rectangular cubic voxels in m³, V is the volume of the rectangular cuboid in m³ and n³ is the number of rectangular cuboid voxels which are contained in the rectangular cuboid, being n=41000, provided that the minimum cross-section of the component associated to each rectangular cubic voxel is the minimum cross-section of the component which comprises the geometrical center of the rectangular cuboid voxel; wherein the % NMVC in the metallic part of the component after the forming step is above 12% and below 24%: wherein the % NMVC in the metallic part of the component after the consolidation step is below 9%; wherein the apparent density of the metallic part of the component after the forming step is higher than 71% and less than 89.8%: wherein the apparent density of the metallic part of the component after the consolidation step is less than 99.8% and wherein the apparent density of the metallic part of the component after the densification step is higher than 96%.[264]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm and/or the nitrogen level of the metallic part of the component is set to more than 0.02 wt % and less than 2.9 wt %; —a consolidation step, wherein a consolidation treatment is applied; —a densification step, wherein a high temperature, high pressure treatment is applied; and —optionally, applying a heat treatment and/or machining; wherein the fixing step comprises the use of an atmosphere with an atomic nitrogen content between 0.78 mol % and 15.21 mol % and/or an % O₂ comprising atmosphere, wherein % O₂ is 0.02 vol % or more; wherein the apparent density of the metallic part of the component after the forming step is higher than 31% and less than 89.8%; wherein the apparent density of the metallic part of the component after the consolidation step is higher than 81% and less than 99.4%; wherein the percentage of reduction of NMVS in the metallic part of the component after the consolidation step is above 2.1%: and wherein the mean cross-section of the component is 0.79 times or less the area of the largest rectangular face of the rectangular cuboid with the minimum possible volume which contains the component.[265]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —a consolidation step, wherein a consolidation treatment is applied: —a densification step, wherein a high temperature, high pressure treatment is applied; and —optionally, applying a heat treatment and/or machining; wherein the significant thickness of the component is more than 0.12 mm and less than 1900 mm.[266]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining; wherein the significant thickness of the component is more than 0.12 mm and less than 1900 mm.[267]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment: —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining; wherein the significant thickness of the component is more than 0.12 mm and less than 580 mm.[268]A method for manufacturing at least part of a metal comprising component comprising the following steps: —providing a mold at least partly manufactured by additive manufacturing: —filling the mold with a powder or powder mixture comprising at least a metal or a metal alloy in powdered form wherein the % O in the powder or powder mixture complies with the formula % O≤KYS*(% Y+1.98*% Sc+0.67*% REE); being KYS=2100; —a forming step, wherein the component is formed by applying a pressure and/or temperature treatment to the mold: —a debinding step, wherein at least part of the mold is eliminated; —a fixing step, wherein the oxygen level of the metallic part of the component is set to more than 260 ppm and less than 19000 ppm and/or the nitrogen level of the metallic part of the component is set to more than 0.02 wt % and less than 2.9 wt %; —a consolidation step, wherein a consolidation treatment is applied: —a densification step, wherein a high temperature, high pressure treatment is applied; and —optionally, applying a heat treatment and/or machining.[269]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; wherein a nitrogen comprising material is admixed in the powder o powder mixture; wherein the amount of nitrogen comprising material is selected so as to have between 0.22 wt % and 2.9 wt % nitrogen; —a forming step, wherein the component is formed by applying a pressure and/or temperature treatment to the mold; —a debinding step, wherein at least part of the mold is eliminated: —a fixing step, wherein the nitrogen level of the metallic part of the component is set to more than 0.02 wt % and less than 2.9 wt %; —a consolidation step, wherein a consolidation treatment is applied; —a densification step, wherein a high temperature, high pressure treatment is applied; and —optionally, applying a heat treatment and/or machining.[270]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: wherein a nitrogen comprising material is admixed in the powder o powder mixture; wherein the amount of nitrogen comprising material is selected so as to have between 0.22 wt % and 3.9 wt % nitrogen; —a forming step, wherein the component is formed by applying a pressure and/or temperature treatment to the mold; —a debinding step, wherein at least part of the mold is eliminated: —a fixing step, wherein the nitrogen level of the metallic part of the component is set to more than 0.02 wt % and less than 3.9 wt %; —a consolidation step, wherein a consolidation treatment is applied; —a densification step, wherein a high temperature, high pressure treatment is applied; and —optionally, applying a heat treatment and/or machining.[271]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 1100 ppm and less than 48000 ppm and a nitrogen content of less than 9000 ppm; —a forming step, wherein the component is formed by applying a pressure and/or temperature treatment to the mold; —a debinding step, wherein at least part of the mold is eliminated: —a fixing step, wherein the oxygen level of the metallic part of the component is set to less than 390 ppm and the nitrogen level of the metallic part of the component is set to more than 1.2 ppm and less than 99 ppm: —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 21% and wherein the % NMVS in the metallic part of the component after the consolidation step is below 14%.[272]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 1100 ppm and less than 48000 ppm and a nitrogen content of less than 9000 ppm; —a forming step, wherein the component is formed by applying a pressure and/or temperature treatment to the mold; —a debinding step, wherein at least part of the mold is eliminated; —applying a pressure and/or temperature treatment: —a fixing step, wherein the oxygen level of the metallic part of the component is set to less than 390 ppm and the nitrogen level of the metallic part of the component is set to more than 1.2 ppm and less than 99 ppm: —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 21% and wherein the % NMVS in the metallic part of the component after the consolidation step is below 14%.[273]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 620 ppm and less than 19000 ppm and a nitrogen content of more than 55 ppm and less than 490 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.2 ppm and less than 140 ppm and the nitrogen level of the metallic part of the component is set to more than 0.06 ppm and less than 49 ppm; —a consolidation step, wherein a consolidation treatment is applied; —a densification step, wherein a high temperature, high pressure treatment is applied; and —optionally, applying a heat treatment and/or machining; wherein the apparent density of the metallic part of the component after the forming step is higher than 31% and wherein the apparent density of the metallic part of the component after the consolidation step is higher than 81% and less than 99.8%. [274]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm, and a nitrogen content of more than 12 ppm and less than 9000 ppm: —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.2 ppm and less than 390 ppm and the nitrogen level of the metallic part of the component is set to more than 0.06 ppm and less than 49 ppm; —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 12% and below 24%; wherein the % NMVC in the metallic part of the component after the consolidation step is below 9%: wherein the apparent density of the metallic part of the component after the forming step is higher than 71% and less than 89.8%; wherein the apparent density of the metallic part of the component after the consolidation step is higher than 81% and wherein the apparent density of the metallic part of the component after the densification step is higher than 96%.[275]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 250 ppm and less than 19000 ppm, and a nitrogen content of more than 12 ppm and less than 9000 ppm; —a forming step, wherein the component is formed by applying a pressure and/or temperature treatment to the mold; —a debinding step, wherein at least part of the mold is eliminated; —applying a pressure and/or temperature treatment: —a fixing step, wherein the oxygen level of the metallic part of the component is set to more than 0.2 ppm and less than 390 ppm and the nitrogen level of the metallic part of the component is set to more than 0.06 ppm and less than 49 ppm; —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 1.2% and below 24%: wherein the % NMVC in the metallic part of the component after the consolidation step is below 9%; wherein the apparent density of the metallic part of the component after the forming step is higher than 71% and less than 89.8% and wherein the apparent density of the metallic part of the component after the densification step is higher than 96%.[276]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 55 ppm and less than 900 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to less than 140 ppm and the nitrogen level of the metallic part of the component is set to less than 49 ppm; —a consolidation step, wherein a consolidation treatment is applied; and —optionally, a densification step, wherein a high temperature, high pressure treatment is applied; —optionally, applying a heat treatment and/or machining: wherein the % NMVS in the metallic part of the component after the forming step is above 31%; wherein the percentage of reduction of NMVS in the metallic part of the component after the consolidation step is above 81% and wherein the percentage of increase of the apparent density of the metallic part of the component after the consolidation step is below 14%.[277]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 620 ppm and a nitrogen content of more than 110 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to less than 390 ppm and the nitrogen level of the metallic part of the component is set to less than 99 ppm: —a consolidation step, wherein a consolidation treatment is applied; and —a densification step, wherein a high temperature, high pressure treatment is applied; and —optionally, applying a heat treatment and/or machining; wherein the % NMVS in the metallic part of the component after the forming step is below 99.8% and wherein the percentage of reduction of NMVS in the metallic part of the component after the consolidation step is above 11%.[278]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 620 ppm and a nitrogen content of more than 110 ppm: —a forming step, wherein the component is formed by applying a pressure and/or temperature treatment to the mold; —a debinding step, wherein at least part of the mold is eliminated; —applying a pressure and/or temperature treatment; —a fixing step, wherein the oxygen level of the metallic part of the component is set to less than 390 ppm and the nitrogen level of the metallic part of the component is set to less than 99 ppm; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is below 99.8% and wherein the percentage of reduction of NMVS in the metallic part of the component after the consolidation step is above 11%. [279]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 620 ppm and less than 9000 ppm and a nitrogen content of less than 9000 ppm: —a forming step, wherein the component is formed by applying a pressure and/or temperature treatment to the mold; —a debinding step, wherein at least part of the mold is eliminated: —a fixing step, wherein the oxygen level of the metallic part of the component is set to less than 140 ppm and the nitrogen level of the metallic part of the component is set to more than 0.06 ppm; —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 0.3% and below 64%; wherein the apparent density of the metallic part of the component after the forming step is higher than 31% and less than 79.8%: wherein the % NMVC in the metallic part of the component after the consolidation step is above 0.006% and below 0.9%; wherein the apparent density of the metallic part of the component after the consolidation step is higher than 81% and less than 98.9% and wherein the percentage of increase of the apparent density of the metallic part of the component after the consolidation step is above 6% and below 69%.[280]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold: —a debinding step, wherein at least part of the mold is eliminated: —a fixing step, wherein the oxygen level of the metallic part of the component is set to more than 0.02 ppm and less than 140 ppm and the nitrogen level of the metallic part of the component is set to more than 0.01 ppm and less than 99 ppm; —a consolidation step, wherein a consolidation treatment is applied; and —optionally, applying a heat treatment and/or machining; wherein the % NMVS in the metallic part of the component after the forming step is above 51% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.6% and below 4% and wherein the apparent density of the metallic part of the component after the consolidation step is higher than 86% and less than 99.8%.[281]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 620 ppm and less than 9000 ppm and a nitrogen content of less than 9000 ppm; —a forming step, wherein the component is formed by applying a pressure and/or temperature treatment to the mold: —a debinding step, wherein at least part of the mold is eliminated; —applying a pressure and/or temperature treatment; —a fixing step, wherein the oxygen level of the metallic part of the component is set to less than 140 ppm and the nitrogen level of the metallic part of the component is set to more than 0.06 ppm; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 31%; wherein the percentage of reduction of NMVS in the metallic part of the component after the consolidation step is above 26%; wherein the apparent density of the metallic part of the component after the consolidation step is less than 93.9%; wherein the percentage of increase of the apparent density of the metallic part of the component after the consolidation step is below 19% and wherein the percentage of reduction of NMVC in the metallic part of the component after the densification step is above 8%.[282]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; with an oxygen content of more than 620 ppm and less than 9000 ppm and a nitrogen content of less than 9000 ppm —a forming step, wherein the component is formed by applying a pressure and/or temperature treatment to the mold; —a debinding step, wherein at least part of the mold is eliminated; —a fixing step, wherein the oxygen level of the metallic part of the component is set to less than 140 ppm and the nitrogen level of the metallic part of the component is set to more than 0.06 ppm: —a consolidation step, wherein a consolidation treatment is applied; —a densification step, wherein a high temperature, high pressure treatment is applied; and —optionally, applying a heat treatment and/or machining: wherein the % NMVS in the metallic part of the component after the forming step is above 31%; wherein the percentage of reduction of NMVS in the metallic part of the component after the consolidation step is above 26%; wherein the apparent density of the metallic part of the component after the consolidation step is less than 93.9% and wherein the percentage of increase of the apparent density of the metallic part of the component after the consolidation step is above 6% and below 59%.[283]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a consolidation step, wherein a consolidation treatment is applied; and —optionally, applying a heat treatment and/or machining; wherein the % NMVS in the metallic part of the component after the forming step is above 31% and below 98%; wherein the apparent density of the metallic part of the component after the forming step is higher than 31% and less than 99.8% and wherein the percentage of increase of the apparent density of the metallic part of the component after the consolidation step is below 29%.[284]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a consolidation step, wherein a consolidation treatment is applied; —a densification step, wherein a high temperature, high pressure treatment is applied; and —optionally, applying a heat treatment and/or machining: wherein the % NMVC in the metallic part of the component after the forming step is above 0.3% and below 64%; wherein the apparent density of the metallic part of the component after the forming step is higher than 31% and less than 79.8%; wherein the % NMVC in the metallic part of the component after the consolidation step is above 0.002% and below 0.9% and wherein the apparent density of the metallic part of the component after the consolidation step is higher than 81% and less than 98.9%.[285]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 12 ppm and less than 9000 ppm: —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 1.2% and below 64%; wherein the apparent density of the metallic part of the component after the forming step is higher than 31% and less than 99.8%; wherein the % NMVS in the metallic part of the component after the consolidation step is above 0.06% and below 39%; wherein the % NMVC in the metallic part of the component after the consolidation step is above 0.002% and below 0.4% and wherein the percentage of increase of the apparent density of the metallic part of the component after the consolidation step is below 29%.[286]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 0.3% and below 64%; wherein the apparent density of the metallic part of the component after the forming step is higher than 41% and less than 89.8%: wherein the % NMVC in the metallic part of the component after the consolidation step is above 0.02% and below 0.9%; wherein the apparent density of the metallic part of the component after the consolidation step is higher than 86% and less than 99.4% and wherein the percentage of increase of the apparent density of the metallic part of the component after the consolidation step is above 11% and below 69%.[287]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; with an oxygen content of more than 250 ppm and less than 9000 ppm and a nitrogen content of more than 12 ppm and less than 900 ppm; —a forming step, wherein the component is formed by applying a pressure and/or temperature treatment to the mold; —a debinding step, wherein at least part of the mold is eliminated: —a fixing step, wherein the oxygen level of the metallic part of the component is set to more than 0.02 ppm and less than 140 ppm and the nitrogen level of the metallic part of the component is set to more than 0.01 ppm and less than 49 ppm; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 51% and below 99.98%; wherein the % NMVC in the metallic part of the component after the forming step is above 1.2% and below 64%: wherein the apparent density of the metallic part of the component after the forming step is higher than 31% and less than 99.8%; wherein the % NMVC in the metallic part of the component after the consolidation step is above 0.002% and below 0.4%; wherein the percentage of increase of the apparent density of the metallic part of the component after the consolidation step is below 29% and wherein the percentage of reduction of NMVS in the metallic part of the component after the consolidation step is above 26%.[288]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —a densification step, wherein a high temperature, high pressure treatment is applied; and —a consolidation step, wherein a consolidation treatment is applied; —a densification step, wherein a high temperature, high pressure treatment is applied; and —optionally, applying a heat treatment and/or machining: wherein the % NMVC in the metallic part of the component after the forming step is above 0.3% and below 64%; wherein the apparent density of the metallic part of the component after the forming step is higher than 31% and less than 79.8%; wherein the % NMVC in the metallic part of the component after the consolidation step is above 0.002% and below 0.9% and wherein the apparent density of the metallic part of the component after the consolidation step is higher than 81% and less than 98.9%.[289]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 12 ppm and less than 9000 ppm: —a forming step, wherein the component is formed by applying a pressure and/or temperature treatment to the mold; —a debinding step, wherein at least part of the mold is eliminated: —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4% and wherein the percentage of increase of the apparent density of the metallic part of the component after the consolidation step is below 29%.[290]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 48000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —applying a pressure and/or temperature treatment; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied: and —optionally, a densification step, wherein a high temperature, high pressure treatment is applied: —optionally, applying a heat treatment and/or machining; wherein the % NMVC in the metallic part of the component after the forming step is above 0.3% and below 64%: wherein the apparent density of the metallic part of the component after the forming step is higher than 41% and less than 89.8%; wherein the % NMVC in the metallic part of the component after the consolidation step is above 0.02% and below 0.9%; wherein the % NMVS in the metallic part of the component after the consolidation step is above 0.06% and below 39%: wherein the apparent density of the metallic part of the component after the consolidation step is higher than 86% and less than 99.4% and wherein the percentage of increase of the apparent density of the metallic part of the component after the consolidation step is above 11% and below 69%.[291]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 9000 ppm and a nitrogen content of more than 12 ppm and less than 900 ppm; —a forming step, wherein the component is formed by applying a pressure and/or temperature treatment to the mold; —a debinding step, wherein at least part of the mold is eliminated: —a fixing step, wherein the oxygen level of the metallic part of the component is set to more than 0.02 ppm and less than 140 ppm and the nitrogen level of the metallic part of the component is set to more than 0.01 ppm and less than 49 ppm; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 51% and below 99.98%: wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4%; wherein the percentage of increase of the apparent density of the metallic part of the component after the consolidation step is below 29% and wherein the percentage of reduction of NMVS in the metallic part of the component after the consolidation step is above 26%.[292]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment: —a densification step, wherein a high temperature, high pressure treatment is applied; and —a consolidation step, wherein a consolidation treatment is applied: —a densification step, wherein a high temperature, high pressure treatment is applied; and —optionally, applying a heat treatment and/or machining: wherein the % NMVC in the metallic part of the component after the forming step is above 0.3% and below 64%: wherein the apparent density of the metallic part of the component after the forming step is higher than 31% and less than 79.8%: wherein the % NMVC in the metallic part of the component after the consolidation step is above 0.002% and below 0.9% and wherein the apparent density of the metallic part of the component after the consolidation step is higher than 81% and less than 98.9%.[293]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm: —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4%; wherein the % NMVS in the metallic part of the component after the consolidation step is above 0.06% and below 39% and wherein the percentage of increase of the apparent density of the metallic part of the component after the consolidation step is below 29%.[294]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 0.3% and below 64%; wherein the apparent density of the metallic part of the component after the forming step is higher than 41% and less than 89.8%; wherein the % NMVC in the metallic part of the component after the consolidation step is above 0.02% and below 0.9%; wherein the apparent density of the metallic part of the component after the consolidation step is higher than 86% and less than 99.4% and wherein the percentage of increase of the apparent density of the metallic part of the component after the consolidation step is above 11% and below 69%.[295]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 9000 ppm and a nitrogen content of more than 12 ppm and less than 900 ppm; —a forming step, wherein the component is formed by applying a pressure and/or temperature treatment to the mold; —a debinding step, wherein at least part of the mold is eliminated: —a fixing step, wherein the oxygen level of the metallic part of the component is set to more than 0.02 ppm and less than 140 ppm and the nitrogen level of the metallic part of the component is set to more than 0.01 ppm and less than 49 ppm; —a consolidation step, wherein a consolidation treatment is applied; —a densification step, wherein a high temperature, high pressure treatment is applied; —optionally, applying a heat treatment and/or machining; wherein the % NMVS in the metallic part of the component after the forming step is above 51% and below 99.98%; wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4%; wherein the percentage of increase of the apparent density of the metallic part of the component after the consolidation step is below 29% and wherein the percentage of reduction of NMVS in the metallic part of the component after the consolidation step is above 26%.[296]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 9000 ppm and a nitrogen content of more than 12 ppm and less than 900 ppm; —a forming step, wherein the component is formed by applying a pressure and/or temperature treatment to the mold; —a debinding step, wherein at least part of the mold is eliminated: —applying a pressure and/or temperature treatment: —a fixing step, wherein the oxygen level of the metallic part of the component is set to more than 0.02 ppm and less than 140 ppm and the nitrogen level of the metallic part of the component is set to more than 0.01 ppm and less than 49 ppm; —a consolidation step, wherein a consolidation treatment is applied; —a densification step, wherein a high temperature, high pressure treatment is applied; and —optionally, applying a heat treatment and/or machining; wherein the % NMVS in the metallic part of the component after the forming step is above 51% and below 99.98%; wherein the % NMVC in the metallic part of the component after the forming step is above 1.2% and below 64%; wherein the apparent density of the metallic part of the component after the forming step is higher than 31% and less than 99.8%; wherein the % NMVC in the metallic part of the component after the consolidation step is above 0.002% and below 0.4%; wherein the percentage of increase of the apparent density of the metallic part of the component after the consolidation step is below 29% and wherein the percentage of reduction of NMVS in the metallic part of the component after the consolidation step is above 26%.[297]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 12 ppm and less than 9000 ppm: —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; wherein the mean pressure applied is at least 1.6 bar and less than 790 bar and wherein the maximum temperature is between 0.36*Tm and 0.88*Tm, being Tm the melting temperature of the metallic powder with the lowest melting point in the powder mixture: —a densification step, wherein a high temperature, high pressure treatment is applied; and —optionally, applying a heat treatment and/or machining; wherein the mean cross-section of the component is 0.79 times or less the area of the largest rectangular face of the rectangular cuboid with the minimum possible volume which contains the component: wherein the % NMVS in the metallic part of the component after the forming step is above 31% and below 99.8%, and the % NMVS in the metallic part of the component after the consolidation step is above 0.02% and below 39%.[298]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.2 ppm and less than 390 ppm and the nitrogen level of the metallic part of the component is set to more than 0.06 ppm and less than 49 ppm; —a consolidation step, wherein a consolidation treatment is applied; —a densification step, wherein a high temperature, high pressure treatment is applied, wherein the maximum pressure applied is between 160 bar and 4900 bar and wherein the maximum temperature is between 0.45*Tm and 0.92*Tm, being Tm the melting temperature of the metallic powder with the lowest melting point in the powder mixture; and —optionally, applying a heat treatment and/or machining; wherein the % NMVC in the metallic part of the component after the forming step is above 3.2% and below 24%, and the % NMVC in the metallic part of the component after the consolidation step is below 14%, wherein the apparent density of the metallic part of the component after the forming step is higher than 41% and less than 89.8%; wherein the apparent density of the metallic part of the component after the consolidation step is less than 89% and wherein the apparent density of the metallic part of the component after the densification step is higher than 96%.[299]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —applying a pressure and/or temperature treatment: —a fixing step, wherein the oxygen level of the metallic part of the component is set to more than 0.2 ppm and less than 390 ppm and the nitrogen level of the metallic part of the component is set to more than 0.06 ppm and less than 49 ppm; —a consolidation step, wherein a consolidation treatment is applied; —a densification step, wherein a high temperature, high pressure treatment is applied, wherein the maximum pressure applied is between 160 bar and 4900 bar and wherein the maximum temperature is between 0.45*Tm and 0.92*Tm, being Tm the melting temperature of the metallic powder with the lowest melting point in the powder mixture; and —optionally, applying a heat treatment and/or machining; wherein the % NMVC in the metallic part of the component after the forming step is above 3.2% and below 24%, and the % NMVC in the metallic part of the component after the consolidation step is below 14%, wherein the apparent density of the metallic part of the component after the forming step is higher than 41% and less than 89.8%; wherein the apparent density of the metallic part of the component after the consolidation step is less than 89% and wherein the apparent density of the metallic part of the component after the densification step is higher than 96%.[300]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied, wherein the mean pressure applied is at least 0.001 bar, but less than 89 bar and wherein the mean temperature is between 0.54*Tm and 0.92*Tm, being Tm the melting temperature of the metallic powder with the lowest melting point in the powder mixture; —a densification step, wherein a high temperature, high pressure treatment is applied; wherein the pressure applied is between 320 bar and 2200 bar and wherein the temperature is between 0.55*Tm and 0.92*Tm, being Tm the melting temperature of the metallic powder with the lowest melting point in the powder mixture; and —optionally, applying a heat treatment and/or machining; wherein the % NMVS in the metallic part of the component after the forming step is above 6% and below 99.98%; wherein the apparent density after the forming step is higher than 31% and less than 99.8%, and wherein the percentage of increase of the apparent density of the metallic part of the component after the consolidation step is below 29%.[301]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a consolidation step, wherein a consolidation treatment is applied, wherein the mean pressure applied is at least 0.01 bar and less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the % NMVS in the metallic part of the component after the forming step is above 6% and below 99.8%; wherein the apparent density of the metallic part of the component after the forming step is higher than 41% and less than 99.98%; wherein the percentage of increase of the apparent density of the metallic part of the component after the consolidation step is below 19% and wherein the largest cross-section of the component is more than 0.2 mm² and 0.49 times or less the area of the largest rectangular face of the rectangular cuboid with the minimum possible volume which contains the component, wherein the cross-sections of the component are each of the minimum cross-sections of the component calculated from each cubic voxel with an edge length of 0.009 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel.[302]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 140 ppm and the nitrogen level of the metallic part of the component is set to more than 0.01 ppm and less than 99 ppm; —a consolidation step, wherein a consolidation treatment is applied, wherein the mean pressure applied is at least 0.001 bar, but less than 89 bar and wherein the mean temperature is between 0.54*Tm and 0.92*Tm, being Tm the melting temperature of the metallic powder with the lowest melting point in the powder mixture; —a densification step, wherein a high temperature, high pressure treatment is applied; wherein the pressure applied is between 320 bar and 2200 bar and wherein the temperature is between 0.55*Tm and 0.92*Tm, being Tm the melting temperature of the metallic powder with the lowest melting point in the powder mixture; and —optionally, applying a heat treatment and/or machining; wherein the % NMVC in the metallic part of the component after the forming step is above 0.3% and below 64%; wherein the apparent density of the metallic part of the component after the forming stop is higher than 31% and less than 79.8%; wherein the % NMVC in the metallic part of the component after the consolidation step is above 0.002% and below 0.9% and wherein the apparent density of the metallic part of the component after the consolidation step is higher than 81% and less than 98.9%.[303]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content of more than 620 ppm and less than 9000 ppm and a nitrogen content of less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to less than 140 ppm and the nitrogen level of the metallic part of the component is set to more than 0.06 ppm; —a consolidation step, wherein a consolidation treatment is applied, wherein the mean pressure applied is at least 0.01 bar and less than 4900 bar and wherein the maximum temperature is between 0.54*Tm and 0.96*Tm, being Tm the melting temperature of the metallic powder with the lowest melting point in the powder mixture: —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the % NMVS in the metallic part of the component after the forming step is above 51% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%, wherein the % NMVC in the metallic part of the component after the consolidation step is above 0.002% and below 4% and wherein the apparent density of the metallic part of the component after the consolidation step is higher than 86% and less than 99.8%.[304]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm and/or the nitrogen level of the metallic part of the component is set to more than 0.02 wt % and less than 2.9 wt %; —a consolidation step, wherein a consolidation treatment is applied; —a densification step, wherein a high temperature, high pressure treatment is applied; and —optionally, applying a heat treatment and/or machining; wherein the fixing step comprises the use of an atmosphere with an atomic nitrogen content between 0.78 mol % and 15.21 mol % and/or an % O₂ comprising atmosphere, wherein % O₂ is 0.02 vol % or more.[305]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; wherein the powder mixture comprises at least one of % Y, % Sc. % REE and/or % Ti; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm; —a consolidation step, wherein a consolidation treatment is applied; —a densification step, wherein a high temperature, high pressure treatment is applied; and —optionally, applying a heat treatment and/or machining; wherein the fixing stop comprises the use of an % O₂ comprising atmosphere with an % O₂ between 0.002 vol % and 89 vol % or less, at a temperature higher than 105° C. and lower than 890° C. which is applied for at least 1 h, but less than 90 h and wherein the % O in the component complies with the formula % O≤KYS*(% Y+1.98*% Sc+2.47*% Ti+0.67*% REE), being KYS=2100.[306]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the consolidation step comprises the use of an atmosphere with an atomic nitrogen content between 0.78 mol % and 15.21 mol % and a temperature which is above 655° C. and below 1440° C., wherein the content of % O, % Sc, % Y, % Ti and % REE in the metallic part of the component after the fixing step complies with the formula KYI*(% Y+1.98% Sc+2.47*% Ti+0.67*% REE)<% O≤KYS*(% Y+1.98*% Sc+2.47*% Ti+0.67*% REE), being KYI=3800 and KYS=2100.[307]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm; —a consolidation step, wherein a consolidation treatment is applied: —a densification step, wherein a high temperature, high pressure treatment is applied; and —optionally, applying a heat treatment and/or machining: wherein the fixing step comprises the use of an % O₂ comprising atmosphere with an % O₂ between 0.002 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98*% Sc+2.47*% Ti+0.67*% REE), being KYS=2100.[308]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —applying a pressure and/or temperature treatment; —a fixing step, wherein the oxygen level of the metallic part of the component is set to more than 260 ppm and less than 19000 ppm; —a consolidation step, wherein a consolidation treatment is applied; and —optionally, a densification step, wherein a high temperature, high pressure treatment is applied; —optionally, applying a heat treatment and/or machining: wherein the fixing step comprises the use of an % O₂ comprising atmosphere with an % O₂ between 0.002 vol % and 89 vol % or less, at a temperature higher than 105° C. and lower than 890° C. which is applied for at least 1 h, but less than 90 h: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98*% Sc+2.47*% Ti+0.67*% REE), being KYS=2100.[309]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm; —a consolidation step, wherein a consolidation treatment is applied; —a densification step, wherein a high temperature, high pressure treatment is applied; and —optionally, applying a heat treatment and/or machining: wherein the fixing step comprises the use of an % O₂ comprising atmosphere with an % O₂ between 0.02 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98*% Sc+0.67*% REE), being KYS=2350.[310]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content which is higher than 410 ppm and lower than 14000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm; —a consolidation step, wherein a consolidation treatment is applied; —a densification step, wherein a high temperature, high pressure treatment is applied; and —optionally, applying a heat treatment and/or machining: wherein the fixing step comprises the use of an % O₂ comprising atmosphere with an % O₂ between 0.002 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26% k and wherein the % NMVC in the metallic part of the component after the consolidation step is above 0.002% and below 0.9%.[31]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content which is higher than 410 ppm and lower than 14000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 14000 ppm; —a consolidation step, wherein a consolidation treatment is applied, wherein the mean pressure applied is at least 0.01 bar, but less than 4900 bar and wherein the maximum temperature is between 0.46*Tm and 0.96*Tm, being Tm the melting temperature of the metallic powder with the lowest melting point in the powder mixture: —a densification step, wherein a high temperature, high pressure treatment is applied; wherein the mean pressure applied is between 160 bar and 2800 bar and wherein the maximum temperature is between 0.45*Tm and 0.92*Tm, being Tm the melting temperature of the metallic powder with the lowest melting point in the powder mixture; and —optionally, applying a heat treatment and/or machining; wherein the fixing step comprises the use of an % O₂ comprising atmosphere, with an % O₂ between 0.002 vol % and 49 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[312]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form comprising a % Yeq(1) content which is higher than 0.03 wt % and lower than 8.9 wt %; —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.2 wt % and 3.9 wt %; —a consolidation step, wherein a consolidation treatment is applied: —a densification step, wherein a high temperature, high pressure treatment is applied; and —optionally, applying a heat treatment and/or machining; wherein the fixing step comprises the use of an atmosphere with an atomic nitrogen content between 0.78 mol % and 15.21 mol % and a temperature which is above 655° C. and below 1440° C.: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26% and wherein the % NMVC in the metallic part of the component after the consolidation step is above 0.002% and below 0.9%.[313]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form comprising a % Yeq(1) content which is higher than 0.03 wt % and lower than 8.9 wt %; —a forming step, wherein the component is formed by applying a pressure and/or temperature treatment to the mold; —a debinding step, wherein at least part of the mold is eliminated; —applying a pressure and/or temperature treatment; —a fixing step, wherein the nitrogen level of the metallic part of the component is set between 0.2 wt % and 3.9 wt %: —a consolidation step, wherein a consolidation treatment is applied: —a densification step, wherein a high temperature, high pressure treatment is applied; and —optionally, applying a heat treatment and/or machining; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26% and wherein the % NMVC in the metallic part of the component after the consolidation step is above 0.002% and below 0.9%.[314]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 2.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining: wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%; wherein the % Yeq(1) content in the component is higher than 0.03 wt % and lower than 8.9 wt %.[315]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a fixing step, wherein the nitrogen level of the metallic part of the component is set between 0.02 wt % and 2.9 wt %: —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining: wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the % Yeq(1) content in the component is higher than 0.03 wt % and lower than 8.9 wt %.[316]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the % Yeq(1) content in the component is higher than 0.03 wt % and lower than 8.9 wt %.[317]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 2.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[318]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture: —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[319]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%. [320]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold: —a debinding step, wherein at least part of the mold is eliminated; —applying a pressure and/or temperature treatment; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step comprises the use of an atmosphere with an atomic nitrogen content between 0.78 mol % and 15.21 mol % and a temperature which is above 655° C. and below 1440° C.: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%: wherein the % NMVC in the metallic part of the component after the consolidation step is above 0.002% and below 0.9% and wherein the apparent density of the metallic part of the component after the densification step is higher than 98.2%.[321]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a fixing step, wherein the nitrogen level of the metallic part of the component is set between 0.02 wt % and 2.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture: —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining: wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming stop is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%; wherein the component has the composition of a nitrogen austenitic steel.[322]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining: wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%: wherein the component has the composition of a nitrogen austenitic steel.[323]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a fixing step, wherein the nitrogen level of the metallic part of the component is set between 0.02 wt % and 3.9 wt %; —a consolidation step, wherein a consolidation treatment is applied: —a densification step, wherein a high temperature, high pressure treatment is applied; and —optionally, applying a heat treatment and/or machining: wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the component comprises at least one material with the composition of a nitrogen austenitic steel.[324]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a fixing step, wherein the nitrogen level of the metallic part of the component is set between 0.02 wt % and 3.9 wt %; —a consolidation step, wherein a consolidation treatment is applied: —a densification step, wherein a high temperature, high pressure treatment is applied; and —optionally, applying a heat treatment and/or machining: wherein the fixing step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the component comprises at least one material with the composition of a nitrogen austenitic steel.[325]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with a content of % V+% Al+% Cr+% Mo+% Ta+% W+% Nb is between 0.12 wt % and 34 wt %; —a forming step, wherein the component is formed by applying a pressure and/or temperature treatment to the mold: —a debinding step, wherein at least part of the mold is eliminated; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing stop comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[326]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with a content of % V+% Al+% Cr+% Mo+% Ta+% W+% Nb between 0.12 wt % and 34 wt %; —a forming step, wherein the component is formed by applying a pressure and/or temperature treatment to the mold; —a debinding step, wherein at least part of the mold is eliminated: —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[327]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step comprises the use of an atmosphere with an atomic nitrogen content between 2.14 mol % and 89 mol % and a temperature which is above 2202° C. and below 980° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%; wherein the content of % V+% Al+% Cr+% Mo+% Ta+% W+% Nb in the component is between 0.12 wt % and 29 wt %.[328]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —applying a pressure and/or temperature treatment; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining: wherein the fixing step comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the content of % V+% Al+% Cr+% Mo+% Ta+% W+% Nb in the component is between 0.12 wt % and 34 wt %.[329]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —applying a pressure and/or temperature treatment; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied: wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step comprises the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%: wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the content of % V+% Al+% Cr+% Mo+% Ta+% W+% Nb in the component is 0.12 wt % and 34 wt %.[330]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the consolidation step comprises the application of a vacuum with an absolute pressure between 0.9*10⁻³ mbar and 0.9*10⁻¹² mbar; wherein the % NMVS in the metallic part of the component after the forming step is above 6% and below 99.8%; wherein the % NMVC in the metallic part of the component after the forming step is above 0.3% and below 64%; wherein the % NMVS in the metallic part of the component after the consolidation step is above 0.02% and below 39% and wherein the % NMVC in the metallic part of the component after the consolidation step is above 0.002% and below 9%.[331]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —applying a pressure and/or temperature treatment; —a consolidation step, wherein a consolidation treatment is applied; —a densification step, wherein a high temperature, high pressure treatment is applied; and —optionally, applying a heat treatment and/or machining; wherein the consolidation step comprises the application of a vacuum with an absolute pressure between 0.9*10⁻³ mbar and 0.9*10⁻¹² mbar; wherein the % NMVS in the metallic part of the component after the forming step is above 6% and below 98%; wherein the % NMVC in the metallic part of the component after the forming step is above 0.3% and below 64%; wherein the % NMVS in the metallic part of the component after the consolidation step is above 0.02% and below 39% and wherein the % NMVC in the metallic part of the component after the consolidation step is above 0.002% and below 9%.[332]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set: —a consolidation step, wherein a consolidation treatment is applied; —a densification step, wherein a high temperature, high pressure treatment is applied; and —optionally, applying a heat treatment and/or machining; wherein the consolidation step comprises the application of a vacuum with an absolute pressure between 0.9*10⁻² mbar and 0.9*10⁻¹² mbar; wherein the % NMVS in the metallic part of the component after the forming step is above 6% and below 99.8%; wherein the % NMVC in the metallic part of the component after the forming step is above 0.3% and below 49%; wherein the % NMVS in the metallic part of the component after the consolidation step is above 0.06% and below 39% and wherein the % NMVC in the metallic part of the component after the consolidation step is above 0.006% and below 9%.[333]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form: —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm —a consolidation step, wherein a consolidation treatment is applied; —a densification step, wherein a high temperature, high pressure treatment is applied; —applying a heat treatment and/or machining; and —optionally, applying a heat treatment and/or machining; wherein the consolidation step comprises the use of an % O₂ comprising atmosphere with an % O₂ between 0.002 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98*% Sc+2.47*% Ti+0.67*% REE), being KYS=2100.[334]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form —a forming step, wherein the component is formed by applying a pressure and/or temperature treatment to the mold; —a debinding step, wherein at least part of the mold is eliminated; —applying a pressure and/or temperature treatment; —a fixing step, wherein the oxygen level of the metallic part of the component is set to more than 260 ppm and less than 19000 ppm; —a consolidation step, wherein a consolidation treatment is applied; —a densification step, wherein a high temperature, high pressure treatment is applied; and —optionally, applying a heat treatment and/or machining; wherein the consolidation step comprises the use of an % O₂ comprising atmosphere with an % O₂ between 0.002 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98/% Sc+2.47*% Ti+0.67*% REE), being KYS=2100.[335]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm; —a consolidation step, wherein a consolidation treatment is applied; —a densification step, wherein a high temperature, high pressure treatment is applied; and —optionally, applying a heat treatment and/or machining; wherein the fixing step and the consolidation step comprises the use of an % O₂ comprising atmosphere with an % O₂ between 0.02 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98*% Sc+0.67*% REE), being KYS=2350.[336]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —applying a pressure and/or temperature treatment; —a fixing step, wherein the oxygen level of the metallic part of the component is set to more than 260 ppm and less than 19000 ppm; —a consolidation step, wherein a consolidation treatment is applied; —a densification step, wherein a high temperature, high pressure treatment is applied; and —optionally, applying a heat treatment and/or machining; wherein the fixing step and the consolidation step comprises the use of an % O₂ comprising atmosphere with an % O₂ between 0.02 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the % O in the component complies with the formula % O≤KYS*(% Y+1.98*% Sc+0.67*% REE), being KYS=2350.[337]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with an oxygen content which is higher than 410 ppm and lower than 14000 ppm: —a forming step, wherein the component is formed by applying a pressure and/or temperature treatment to the mold; —a debinding step, wherein at least part of the mold is eliminated; —a fixing step, wherein the oxygen level of the metallic part of the component is set to more than 260 ppm and less than 19000 ppm; —a consolidation step, wherein a consolidation treatment is applied; —a densification step, wherein a high temperature, high pressure treatment is applied; and —optionally, applying a heat treatment and/or machining; wherein the consolidation step comprises the use of an % O₂ comprising atmosphere, with an % O₂ between 0.002 vol % and 89 vol % or less, at a temperature higher than 105° C. and lower than 890° C. which is applied for at least 1 h, but less than 90 h; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26% and wherein the % NMVC in the metallic part of the component after the consolidation step is above 0.002% and below 0.9%.[338]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form comprising a % Yeq(1) content which is higher than 0.03 wt % and lower than 8.9 wt %; —a forming step, wherein the component is formed by applying a pressure and/or temperature treatment to the mold; —a debinding step, wherein at least part of the mold is eliminated: —a fixing step, wherein the nitrogen level of the metallic part of the component is set between 0.02 wt % and 2.9 wt %; —a consolidation step, wherein a consolidation treatment is applied; —a densification step, wherein a high temperature, high pressure treatment is applied; and —optionally, applying a heat treatment and/or machining; wherein the fixing step and the consolidation step comprise the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26% and wherein the % NMVC in the metallic part of the component after the consolidation step is above 0.002% and below 0.9%.[339]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 2.9 wt %: —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the consolidation step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the % Yeq(1) content in the component is higher than 0.03 wt % and lower than 8.9 wt %.[340]A method for manufacturing at least part of a metal comprising component, which method comprises the following steps: —providing a mold at least partly manufactured by additive manufacturing; —filling the mold with a powder or powder mixture comprising at least a metal or a metal alloy comprising a nitrogen austenitic steel in powdered form; —a forming step, wherein the component is formed by applying a pressure and/or temperature treatment to the mold: —a debinding step, wherein at least part of the mold is eliminated; —a fixing step, wherein the nitrogen level of the metallic part of the component is set between 0.2 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture: —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the consolidation step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%: wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[341]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —applying a pressure and/or temperature treatment; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step and the consolidation step comprise the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%: wherein the apparent density of the metallic part of the component after the densification step is higher than 98.2% and wherein the component has the composition of a nitrogen austenitic steel.[342]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the consolidation step comprises the use of an atmosphere with an atomic nitrogen content between 0.78 mol % and 15.21 mol % and a temperature which is above 655° C. and below 1440° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%: wherein the % NMVC in the metallic part of the component after the consolidation step is above 0.002% and below 0.9%; wherein the apparent density of the metallic part of the component after the densification step is higher than 98.2% and wherein the component comprises at least one material with the composition of a nitrogen austenitic steel.[343]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form with a content of % V+% Al+% Cr+% Mo+% Ta+% W+% Nb between 0.12 wt % and 34 wt %; —a forming step, wherein the component is formed by applying a pressure and/or temperature treatment to the mold; —a debinding step, wherein at least part of the mold is eliminated: —applying a pressure and/or temperature treatment; —a fixing step, wherein the nitrogen level of the metallic part of the component is set between 0.2 wt % and 3.9 wt %: —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the consolidation step comprises the use of an atmosphere with an atomic nitrogen content between 2.14 mol % and 89 mol % and a temperature which is above 220° C. and below 980° C.: wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9% and wherein the apparent density of the metallic part of the component after the densification step is higher than 98.2%.[344]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a fixing step, wherein the nitrogen level of the metallic part of the component is set between 0.02 wt % and 3.9 wt %; —a consolidation step, wherein a consolidation treatment is applied, wherein the mean pressure applied is at least 0.01 bar, but less than 4900 bar and wherein the maximum temperature is between 0.54*Tm and 0.96*Tm, being Tm the melting temperature of the metallic powder with the lowest melting point in the powder mixture; —a densification step, wherein a high temperature, high pressure treatment is applied; wherein the mean pressure applied is between 160 bar and 2800 bar and wherein the maximum temperature is between 0.55*Tm and 0.92*Tm, being Tm the melting temperature of the metallic powder with the lowest melting point in the powder mixture; and —optionally, applying a heat treatment and/or machining; wherein the fixing step and the consolidation step comprise the use of an atmosphere with an atomic nitrogen content between 2.14 mol % and 89 mol % and a temperature which is above 220° C. and below 980° C.; wherein the % NMVS in the metallic part of the component after the forming step is above 6% and below 99.98%; wherein the % NMVC in the metallic part of the component after the forming step is above 0.3% and below 64%; wherein the apparent density of the metallic part of the component after the forming step is higher than 31% and less than 99.8%; wherein the percentage of reduction of NMVS in the metallic part of the component after the consolidation step is above 26%; wherein the % NMVC in the metallic part of the component after the consolidation step is above 0.002% and below 0.9%; wherein the apparent density of the metallic part of the component after the densification step is higher than 98.2% and wherein the content of % V+% Al+% Cr+% Mo+% Ta+% W+% Nb in the component is between 0.12 wt % and 34 wt %.[345]A method for manufacturing at least part of a metal comprising component comprising the following steps —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated: —a consolidation step, wherein a consolidation treatment is applied; —a densification step, wherein a high temperature, high pressure treatment is applied; and —optionally, applying a heat treatment and/or machining, wherein the component comprises fine channels with a H value greater than 12 and less than 1098, being H=the total length of the fine channels/the mean length of the fine channels; wherein the equivalent diameter of the fine channels is between 0.1 mm to 128 mm; wherein the number of fine channels per square meter of thermo-regulated surface is between 21 and 14000: wherein the fluid flows in the fine channels in such a way that the mean Reynolds number is maintained greater than 810 and less than 89000; wherein the component comprises at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C.[346]A method for manufacturing at least part of a metal comprising component comprising the following steps —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment: —a fixing step, wherein the oxygen and/or nitrogen level of the metallic part of the component is set: —a consolidation step, wherein a consolidation treatment is applied; —a densification step, wherein a high temperature, high pressure treatment is applied; and —optionally, applying a heat treatment and/or machining; wherein the component comprises fine channels and main channels; wherein the mean cross-section of the main channels is at least 6 times higher than the cross-section of the smallest channel among all the fine channels in the component area where the thermo-regulation is desired; wherein the distance from the fine channels to the surface to be thermo-regulated is between 0.6 mm and 32 mm; wherein the equivalent diameter of the fine channels is between 0.1 mm to 128 mm; wherein the number of fine channels per square meter of thermo-regulated surface is between 21 and 14000; wherein the fluid flows in the fine channels in such a way that the mean Reynolds number is maintained greater than 810 and less than 89000; wherein the rugosity of the channels is between 0.9 microns and 190 microns; wherein the component comprises at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C.[347]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —applying a pressure and/or temperature treatment; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining; wherein the component comprises comprising fine channels, wherein the distance from the fine channels to the surface to be thermo-regulated is between 0.6 mm and 32 mm; wherein the equivalent diameter of the fine channels is between 0.1 mm to 128 mm; wherein the number of fine channels per square meter of thermo-regulated surface is between 21 and 14000; wherein the fluid flows in the fine channels in such a way that the mean Reynolds number is maintained greater than 810 and less than 89000 and wherein the rugosity of the channels is at least 0.9 microns and less than 190 microns.[348]A method for manufacturing at least part of a metal comprising component, which method comprises the following steps: —providing a mold at least partly manufactured by additive manufacturing: —filling the mold with a powder or powder mixture comprising at least a metal or a metal alloy in powdered form comprising powder mixture with an oxygen content of more than 250 ppm and less than 19000 ppm and a nitrogen content of more than 12 ppm and less than 9000 ppm; —a forming step, wherein the component is formed by applying a pressure and/or temperature treatment to the mold; —a debinding step, wherein at least part of the mold is eliminated; —a fixing step, wherein the oxygen level of the metallic part of the component is set to more than 0.02 ppm and less than 390 ppm and the nitrogen level of the metallic part of the component is set to more than 0.01 ppm and less than 99 ppm; —a consolidation step, wherein a consolidation treatment is applied; —a densification step, wherein a high temperature, high pressure treatment is applied; and —optionally, applying a heat treatment and/or machining; wherein the % NMVC in the metallic part of the component after the forming step is above 1.2% and below 64%: wherein the apparent density of the metallic part of the component after the forming step is higher than 31% and less than 99.8%; wherein the % NMVS in the metallic part of the component after the consolidation step is above 0.06% and below 39%; wherein the % NMVC in the metallic part of the component after the consolidation step is above 0.002% and below 0.4%; wherein the percentage of increase of the apparent density of the metallic part of the component after the consolidation step is below 29% and wherein the component comprises fine channels with an equivalent diameter between 0.1 mm and 128 mm and at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C. and less than 199° C.[349]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the volume of the component is more than 2% and less than 89% of the volume of a rectangular cuboid with the minimum possible volume which contains the component and wherein the component comprises fine channels; and main channels; wherein the cross-section of the main channels is at least 3 times higher than the cross-section of the smallest channel among all the fine channels in the component area where the thermo-regulation is desired; wherein the distance from the fine channels to the surface to be thermo-regulated is between 1.2 mm and 19 mm; wherein the equivalent diameter of the fine channels is between 1.2 mm and 18 mm; wherein the number of fine channels per square meter of thermo-regulated surface is between 61 and 4000; wherein the fluid flows in the fine channels in such a way that the mean Reynolds number is maintained greater than 2800 and less than 26000: wherein the rugosity of the channels is at least 10.2 microns and less than 98 microns: wherein the component comprises at least one inlet collector and one outlet collector connected by more than one fine channel with a temperature gradient within the collector below 9° C. and wherein the temperature gradient between the two insertion points of the fine channels to the collectors, for the 20% of the fine channels whose temperature gradients between their two insertion points are greater, is more than 2.6° C.[350]A method for manufacturing at least part of a metal comprising component, which method comprises the following steps: —providing a mold at least partly manufactured by additive manufacturing; —filling the mold with a powder or powder mixture comprising at least a metal or a metal alloy in powdered form; —a forming step, wherein the component is formed by applying a pressure and/or temperature treatment to the mold; —a debinding step, wherein at least part of the mold is eliminated; —a fixing step, wherein the oxygen and/or nitrogen level of the metallic part of the component is set; —a consolidation step, wherein a consolidation treatment is applied; —a densification step, wherein a high temperature, high pressure treatment is applied; and —optionally, applying a heat treatment and/or machining; wherein the mean cross-section of the component is more than 0.2 mm² and less than 49% of the area of the largest rectangular face of a rectangular cuboid with the minimum possible volume which contains the component and is the largest cross-section obtained after excluding the 40% of the largest cross-sections of the component, wherein the cross-sections of the component are each of the minimum cross-sections of the component calculated from each cubic voxel with an edge length of 0.09 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel and wherein the component comprises fine channels with a mean length between 0.6 mm and 1.8 m, and at least one inlet collector and one outlet collector connected by more than one fine channel with a temperature gradient within the collector below 39° C.; wherein the temperature gradient between the two insertion points of the fine channels to the collectors, for the 50% of the fine channels whose temperature gradients between their two insertion points are greater, is more than 1.1° C. and less than 199° C.

[351]A powder or powder mixture comprising at least a powder LP.[352] A powder or powder mixture], wherein the powder or powder mixture comprises at least a powder SP.[353] A powder or powder mixture wherein the powder or powder mixture comprises at least a powder LP and SP.[354] The powder or powder mixture according to any of [1] to [353], wherein LP and SP are the same powder.[355] powder or powder mixture according to any of [1] to [354], wherein LP and SP have the same composition.[356]A powder or powder mixture comprising at least a powder P1.[357] powder or powder mixture comprising at least a at least a powder P2.[358] powder or powder mixture comprising at least a at least a powder P3.[359] The powder mixture according to any of [1] to [358], wherein the powder or powder mixture comprises at least a powder P4.[360]The powder or powder mixture according to any of [1] to [359], wherein LP is a powder having the following composition, all percentages being indicated in weight percent: % Mo: 0-3.9; % W: 0-3.9; % Moeq: 0.6-3.9; % Ceq: 0-0.49; % C: 0-0.49; % N: 0-0.2; % B: 0-0.8; % Si: 0-2.5; % Mn: 0-2.9; % Ni: 0-2.9; % Mn+2*% Ni: 0-3.8; % Cr: 0-2.9; % V: 0-2.9; % Nb: 0-2.9; % Zr: 0-3.9; % Hf: 0-2.9; % Ta: 0-2.9; % S: 0-0.8; % P: 0-0.8; % Pb: 0-1.9; % Cu: 0-3.9; % Bi: 0-0.8; % Se: 0-0.8; % Co: 0-3.9; % REE: 0-1.4; % Y: 0-0.96; % Sc: 0-0.96; % Cs: 0-1.4; % O: 0-0.299; the rest consisting of iron and trace elements: wherein % Ceq=% C+0.86*% N+1.2*% B and % Moeq=% Mo+*% W.[361]The powder or powder mixture according to any of [1] to [360], wherein SP is a powder having the following composition, all percentages being indicated in weight percent: % Mo: 0-0.9; % W: 0-0.9; % Moeq: 0-0.9; % Ceq: 0-2.9; % C: 0-2.9; % N: 0-0.2; % B: 0-0.8; % Si: 0-0.9; % Mn: 0-1.9; % Ni: 0-2.9; % Mn+2*% Ni: 0-3.8; % Cr: 0-1.9; % V: 0-0.9; % Nb: 0-0.9; % Zr: 0-0.4; % Hf: 0-0.4; % Ta: 0-0.4; % S: 0-0.2: % P: 0-0.09: % Pb: 0-0.9; % Cu: 0-1.9; % Bi: 0-0.2; % Se: 0-0.2; % Co: 0-1.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% kB and % Moeq=% Mo+W*% W.[362]The powder or powder mixture according to any of [1] to [361], wherein LP is a powder having the following composition, all percentages being indicated in weight percent: % Mo: 0-8.9; % W: 0-3.9; % Moeq: 1.6-8.9; % Ceq: 0-1.49; % C: 0-1.49; % N: 0-0.2; % B: 0-0.8; % Si: 0-2.5; % Mn: 0-2.9; % Ni: 0-2.9; % Mn+2*% Ni: 0-6.8; % Cr: 0-2.9; % V: 0-3.9; % Nb: 0-2.9; % Zr: 0-3.9; % Hf: 0-2.9; % Ta: 0-2.9; % S: 0-0.8; % P: 0-0.8; % Pb: 0-1.9; % Cu: 0-3.9; % Bi: 0-0.8; % Se: 0-0.8; % Co: 0-3.9; % REE: 0-1.4; % Y: 0-0.96: % Sc: 0-0.96; % Cs: 0-1.4; % O: 0-0.299; the rest consisting of iron and trace elements, wherein % Ceq=% C+0.86*% N+1.2*% B and % Moeq=% Mo+h*% W.[363]The powder or powder mixture according to any of [1] to [362], wherein SP is a powder having the following composition, all percentages being indicated in weight percent: % Mo: 0-2.9; % W: 0-2.9; % Moeq: 0-2.9; % Ceq: 0-2.99; % C: 0-2.99; % N: 0-0.2; % B: 0-0.8; % Si: 0-0.9; % Mn: 0-1.9; % Ni: 0-2.9; % Mn+2*% Ni: 0-6.8; % Cr: 0-1.9; % V: 0-0.9; % Nb: 0-0.9; % Zr: 0-0.4; % Hf: 0-0.4: % Ta: 0-0.4; % S: 0-0.2; % P: 0-0.09; % Pb: 0-0.9; % Cu: 0-1.9; % Bi: 0-0.2; % Se: 0-0.2; % Co: 0-1.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq=% Mo+½*% W.[364]The powder or powder mixture according to any of [1] to [363], wherein LP is a powder having the following composition, all percentages being indicated in weight percent: % Mo: 0-4.9; % W: 0-4.9; % Moeq: 0-4.9; % Ceq: 0.15-2.49; % C: 0.15-2.49; % N: 0-0.9; % B: 0-0.08; % Si: 0-2.5;% Mn: 0-2.9; % Ni: 0-3.9; % Cr: 11.5-19.5; % V: 0-3.9; % Nb: 0-2.9; % Zr: 0-3.9; % Hf: 0-2.9; % Ta: 0-2.9; % S: 0-0.8; % P: 0-0.8; % Pb: 0-1.9; % Cu: 0-3.9; % Bi: 0-0.8; % Se: 0-0.8; % Co: 0-3.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq-% Mo+½*% W.[365]The powder or powder mixture according to any of [1] to [364], wherein SP is a powder having the following composition, all percentages being indicated in weight percent: % Mo: 0-2.9:% W: 0-2.9; % Moeq: 0-2.9; % Ceq: 0-2.99; % C: 0-2.99; % N: 0-0.2; % B: 0-0.8; % Si: 0-1.9; % Mn: 0-2.9; % Ni: 0-3.9; % Cr: 0-19; % V: 0-1.9; % Nb: 0-0.9; % Zr: 0-0.4; % Hf: 0-0.4; % Ta: 0-0.4: % S: 0-0.2; % P: 0-0.09; % Pb: 0-0.9; % Cu: 0-1.9; % Bi: 0-0.2; % Se: 0-0.2; % Co: 0-1.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq=% Mo+*% W.[366]The powder or powder mixture according to any of [1] to [365], wherein LP is a powder having the following composition, all percentages being indicated in weight percent: % Mo: 0.05-2.9; % W: 0-3.9; % Moeq: 0.05-2.9; % Ceq: 0.002-0.14: % C: 0.002-0.09; % N: 0-2.0: % B: 0-0.08: % Si: 0.05-1.5% Mn: 0.05-1.5; % Ni: 9.5-11.9; % Cr: 10.5-13.5; % Ti: 0.5-2.4; % Al: 0.001-1.5; % V: 0-0.4; % Nb: 0-0.9; % Zr: 0-0.9; % Hf: 0-0.9; % Ta: 0-0.9; % S: 0-0.08; % P: 0-0.08; % Pb: 0-0.9; % Cu: 0-3.9; % Bi: 0-0.08: % Se: 0-0.08; % Co: 0-3.9; % REE: 0-1.4; % Y: 0-0.96; % Sc: 0-0.96; % Cs: 0-1.4; % O: 0-0.299% Y+% Sc+% REE: 0.006-1.9%; the rest consisting of iron and trace elements: wherein % Ceq=% C+0.86*% N+1.2*% B and % Moeq-% Mo+½*% W.[367]The powder or powder mixture according to any of [1] to [366], wherein SP is a powder having the following composition all percentages being indicated in weight percent: % Mo: 0-2.9; % W: 0-2.9; % Moeq: 0-2.9; % Ceq: 0-2.99; % C: 0-2.99; % N: 0-0.2;% B: 0-0.8;% Si: 0-1.9;% Mn: 0-2.9; % Ni: 0-3.9;% Cr: 0-19;% V: 0-1.9; % Nb: 0-0.9; % Zr: 0-0.4; % Hf: 0-0.4; % Ta: 0-0.4; % S: 0-0.2; % P: 0-0.09: % Pb: 0-0.9; % Cu: 0-1.9; % Bi: 0-0.2; % Se: 0-0.2; % Co: 0-1.9; % REE: 0-1.4; % Y: 0-0.96; % Sc: 0-0.96; % Cs: 0-1.4; % O: 0-0.299; the rest consisting of iron and trace elements; wherein % Ceq=% C+0.86*% N+1.2*% B and % Moeq=% Mo+%*% W.[368]The powder or powder mixture according to any of [1] to [367], wherein AP1 is a powder having the following composition, all percentages being indicated in weight percent: % Moeq: 40 99.999; % Mo: 0-99.999; % W: 0-99.9; % Ceq: 0-2.99; % C: 0-2.99; % N: 0-2.2; % B: 0-2.9; % O≤0-8; % Cr: 0-9: % V: 0-5; % Mn+% Ni+% Si: 0-12; the rest consisting of iron and trace elements: wherein % Ceq=% C+0.86*% N+1.2/% B and % Moeq=% Mo+%*% W.[369]The method according to any of [1] to [368], wherein AP2 is a powder comprising at least 66 wt % of % C.[370]The method according to any of [1] to [369], wherein AP2 is a powder comprising at least 86 wt % of % C.[371]The powder or powder mixture according to any of [1] to [370], wherein AP2 is a carbonyl iron powder.[372]The powder or powder mixture according to any of [1] to [371], wherein, the % C of AP2 is constituted to at least 52% graphite.[373]The powder or powder mixture according to any of [1] to [372], wherein, the % C of AP2 is constituted to at least 52% of fullerene carbon. [374]The powder or powder mixture according to any of [1] to [373], wherein, AP2 is not present. [375]The powder or powder mixture according to any of [1] to [374], wherein AP3 is a powder having the following composition, all percentages being indicated in weight percent: % Mn+% Ni+% Si: 22-99.999; % Moeq: 0-9.0; % Mo: 0-9.0; % W: 0-9.0; % Ceq: 0-2.99; % C: 0-2.99; % N: 0-2.2; % B: 0-2.9; % O: 0-8; % Cr: 0-9; % V: 0-5; the rest consisting of iron and trace elements; wherein % Ceq-% C+0.86*% N+1.2*% B and % Moeq=% Mo+*% W.[376]The powder or powder mixture according to any of [1] to [375], wherein AP4 is a powder having the following composition, all percentages being indicated in weight percent: % V+% Moeq+% Mn+% Ni+% Si: 40-99.999; % Mo: 0-99.999; % W: 0-99.9; % Ceq: 0-2.99; % C: 0-2.99: % N: 0-2.2; % B: 0-2.9; % O: 0-8; % Cr: 0-9; % V: 0-99.99; % Mn+% Ni+% Si: 0-82; the rest consisting of iron and trace elements; wherein % Ceq=% C+0.86*% N+1.2*% B and % Moeq=% Mo+*% W. [377]The powder or powder mixture according to any of [1] to [376], wherein the theorical composition of the powder or powder mixture has the following elements and limitations, all percentages being indicated in weight percent: % C: 0.25-0.8; Mn: 0-1.15; % Si: 0-0.35: Cr: 0.1 max; % Mo: 1.5-6.5; % V: 0-0.6; % W: 0-4: Ni: 0-4; % Co: 0-3: balance Fe and trace elements.[378]The powder or powder mixture according to any of [1] to [377], wherein the theorical composition of the powder or powder mixture has the following elements and limitations, all percentages being indicated in weight percent: % C: 0.25-0.55; % Mn: 0.10-1.2; % Si: 0.10-1.20; % Cr: 2.5-5.50; % Mo: 1.00-3.30; % V: 0.30-1.20; balance Fe and trace elements.[379]The powder or powder mixture according to any of [1] to [378], wherein, the theorical composition of the powder or powder mixture has the following elements and limitations, all percentages being indicated in weight percent: % C: 0.15-2.35; % Mn: 0.10-2.5; % Si: 0.10-1.0; % Cr: 0.2-17.50: % Mo: 0-1.4; % V: 0-1; % W: 0-2.2: % Ni: 0-4.3; balance Fe and trace elements.[380]The powder or powder mixture according to any of [1] to [379], wherein the theorical composition of the powder or powder mixture has the following elements and limitations, all percentages being indicated in weight percent: % C: 0-0.4; % Mn: 0.1-1; % Si: 0-0.8; % Cr: 0-5.25; % Mo: 0-1.0; % V: 0-0.25: % Ni: 0-4.25; % Al: 0-1.25; balance Fe and trace elements.[381]The powder or powder mixture according to any of [1] to [380], wherein the theorical composition of the powder or powder mixture has the following elements and limitations, all percentages being indicated in weight percent: % C: 0.77-1.40; % Si: 0-0.70; % Cr: 3.5-4.5; % Mo: 3.2-10; % V: 0.9-3.60: % W: 0-18.70: % Co: 0-10.50; balance Fe and trace elements.[382]The powder or powder mixture according to any of [1] to [381], wherein the theorical composition of the powder or powder mixture has the following elements and limitations, all percentages being indicated in weight percent: % C: 0.03 max; % Mn-0.1 max; % Si: 0.1 max; % Mo: 3.0-5.2: % Ni: 18-19; % Co: 0-12.5; % Ti: 0-2; balance Fe and trace elements.[383]The method according to any of [1] to [382], wherein the theorical composition of the powder or powder mixture has the following elements and limitations, all percentages being indicated in weight percent: % C: 1.5-1.85; % Mn: 0.15-0.5; % Si: 0.15-0.45; % Cr: 3.5-5.0; % Mo: 0-6.75; % V: 4.5-5.25; % W: 11.5-13.00: % Co: 0-5.25; balance Fe and trace elements.[384]The powder or powder mixture according to any of [1] to [383], wherein the theorical composition of the powder or powder mixture has the following elements and limitations, all percentages being indicated in weight percent: % C: 0-0.6; % Mn: 0-1.5; % Si: 0-1; % Cr: 11.5-17.5; % Mo: 0-1.5; % V: 0-0.2; % Ni: 0-6.0; balance Fe and trace elements.[385]The powder or powder mixture according to any of [1] to [384], wherein the theorical composition of the powder or powder mixture has the following elements and limitations, all percentages being indicated in weight percent: C: 0.015 max; Mn: 0.5-1.25; Si: 0.2-1; Cr: 11-18: Mo: 0-3.25; Ni: 3.0-9.5; Ti: 0-1.40: Al: 0-1.5: Cu: 0-5; balance Fe and trace elements.[386]The powder or powder mixture according to any of [1] to [385], wherein the theorical composition of the powder or powder mixture has the following elements and limitations, all percentages being indicated in weight percent: % Mg: 0.006-10.6; % Si: 0.006-23: % Ti: 0.002-0.35; % Cr: 0.01-0.40: % Mn—0.002-1.8; % Fe: 0.006-1.5; % Ni: 0-3.0; % Cu: 0.006-10.7; % Zn: 0.006-7.8; % Sn: 0-7; % Zr: 0-0.5: balance Al and trace elements.[387]The powder or powder mixture according to any of [1] to [388], wherein the theorical composition of the powder or powder mixture has the following elements and limitations, all percentages being indicated in weight percent: Zn: 0-40; Ni: 0-31; Al: 0-13; Sn: 0-10; Fe: 0-5.5: Si: 0-4; Pb: 0-4: Mn: 0-3; Co: 0-2.7; Be: 0-2.75: Cr: 0-1; balance Cu and trace elements.[388]The powder or powder mixture according to any of [1] to [387], wherein the theorical composition of the powder or powder mixture has the following elements and limitations, all percentages being indicated in weight percent: % Be: 0.15-3.0; % Co: 0-3; % Ni: 0-2.2; % Pb: 0-0.6; % Fe: 0-0.25: % Si: 0-0.35; % Sn: 0-0.25, % Zr 0-0.5; balance Cu and trace elements.[388]The powder or powder mixture according to any of [1] to [388], wherein the theorical composition of the powder or powder mixture has the following elements and limitations, all percentages being indicated in weight percent: % Cr: 9-33; % W: 0-26; % Mo: 0-29; % C: 0-3.5; % Fe: 0-9; % Ni: 0-35; % Si: 0-3.9; Mn: 0-2.5; % B: 0-1; % V: 0-4.2; % Nb/% Ta: 0-5.5; balance Co and trace elements.[390]The powder or powder mixture according to any of [1] to [389], wherein the theorical composition of the powder or powder mixture has the following elements and limitations, all percentages being indicated in weight percent: % Fe: 0-42: % Cu: 0-34; % Cr: 0-31; % Mo: 0-24; % Co: 0-18; % W: 0-14; % Nb: 0-5.5; % Mn: 0-5.25; % Al: 0-5; Ti: 0-3; % Zn: 0-1; % Si: 0-1; % C: 0-0.3; % S: 0.01 max; balance Ni and trace elements.[391]The powder or powder mixture according to any of [1] to [390], wherein the theorical composition of the powder or powder mixture has the following elements and limitations, all percentages being indicated in weight percent: % V: 0-14.5; % Mo: 0-13; % Cr: 0-12; %/*Sn: 0-11.5; % Al: 0-8; % Mn: 0-8; % Zr: 0-7.5; % Cu: 0-3; % Nb: 0-2.5; % Fe: 0-2.5: % Ta: 0-1.5; % S: 0-0.5:% C: 0.1 max: % N: 0.05 max; % O: 0.2 max; % H: 0.03 max; balance Ti and trace elements.[392]The powder or powder mixture according to any of [1] to [391], wherein, the theorical composition of the powder or powder mixture has the following elements and limitations, all percentages being indicated in weight percent: % Al: 0-10; % Zn: 0-6; % Y: 0-5.2; % Cu: 0-3; % Ag: 0-2.5, % Th: 0-3.3: Si: 0-1.1: % Mn: 0-0.75: balance Mg and trace elements.[393]The powder or powder mixture according to any of [1] to [392], wherein the powder or powder mixture mean composition, has the following compositional range, all percentages being indicated in weight percent: % Mo: 0-6.8; % W: 0-6.9; % Moeq: 0-6.8; % Ceq: 0.16-1.8; % C: 0-1.29; % N: 0.11-2.09; % B: 0-0.14;% Si: 0-1.5; % Mn: 0-24; % Ni: 0-18.9; % Cr: 12.1-38; % Ti: 0-2.4;% Al: 0-14;% V: 0 4: % Nb: 0-4: % Zr: 0-3: % Hf: 0-3; % Ta: 0-3: % S: 0-0.098; % P: 0-0.098; % Pb: 0-0.9; % Cu: 0-3.9; % Bi: 0-0.08; % Se: 0-0.08; % Co: 0-14; % REE: 0-4; % Y: 0-1.86; % Sc: 0-0.96; % Cs: 0-1.4; % O: 0.00012-0.899: % Y+% Sc+% REE: 0.0022-3.9%; the rest consisting of iron and trace elements; wherein % Ceq=% C+0.86*% N+1.2*% B and % Moeq=% Mo+½*% W.[394]The powder or powder mixture according to any of [1] to [393], wherein, the trace refers to any of the following elements: H, He, Xe, F, S, P. Cu, Pb, Co, Ta, Zr, Nb, Hf, Cs, Y, Sc, Mn, Ni, Mo, W, C, N, B, O, Cr, Fe, Ne, Na, Cl, Ar, K, Br, Kr, Sr, Tc, Ru, Rh, Ti, Pd. Ag, I, Ba, Re, Os, Ir, Pt. Au, Hg, Tl, Po, At, Rn, Fr, Ra, Ac, Th, Pa, U. Np, Pu, Am, Cm, Bk, Cf, Es. Fm, Md, No, Lr, La, Ce, Pr, Nd, Pm, Sm. Eu, Gd, Tb, Dy, Ho, Er, Tm, Yb, Lu, Rf, Db, Sg, Bh, Hs, Li, Be, Mg, Ca, Rb, Zn, Cd. Al, Ga, In, Ge. Sn, Bi, Sb, As, Se. Te, Ds, Rg, Cn. Nh, Fl. Mc. Lv, Ts, Og and Mt, excluding those elements listed in the composition of the alloy.[395]The powder or powder mixture according to any of [1] to [394], wherein the sum of all trace elements is below 2.0 wt %.[396]The powder or powder mixture according to any of [1] to [395], wherein the powder or powder mixture comprises at least one spherical powder.[397]The powder or powder mixture according to any of [1] to [396], wherein LP is a spherical powder.[398]The powder or powder mixture according to any of [1] to [397], wherein SP is a spherical powder.[399]The powder or powder mixture according to any of [1] to [398], wherein a spherical powder is a powder with a sphericity above 76%.[400]The powder or powder mixture according to any of [1] to [399], wherein a spherical powder is a powder with a sphericity above 82%.[401]The powder or powder mixture according to any of [1] to [400], wherein a spherical powder is a powder with a sphericity above 92%.[402]The powder or powder mixture according to any of [1] to [401], wherein a spherical powder is a powder obtained by gas atomization.[403]The method according to any of [1] to [402], wherein a spherical powder is a powder obtained by centrifugal powder or powder mixture,[404]The powder or powder mixture according to any of [1] to [403], wherein a spherical powder is a powder rounded with a plasma treatment.[405]The powder or powder mixture according to any of [1] to [404], wherein the powder or powder mixture comprises at least one non-spherical powder.[406]The powder or powder mixture according to any of [1] to [405], wherein LP is a non-spherical powder.[407]The powder or powder mixture according to any of [1] to [406], wherein SP is a non-spherical powder.[408]The powder or powder mixture according to any of [1] to [407], wherein a non-spherical powder is a powder mechanically crushed.[409]The powder or powder mixture according to any of [1] to [408], wherein a non-spherical powder is a powder obtained by water atomization.[410]The powder or powder mixture according to any of [1] to [409], wherein a non-spherical powder is a powder with a sphericity below 99%,[411]The powder or powder mixture according to any of [1] to [410], wherein a non-spherical powder is a powder with a sphericity below 89%.[412]The powder or powder mixture according to any of [1] to [411], wherein a non-spherical powder is a powder with a sphericity below 79%.[413]The powder or powder mixture according to any of [1] to [412], wherein the volume percentage of LP in the powder mixture is 85 vol % or more.[414]The powder or powder mixture according to any of [1] to [413], wherein LP is a spherical powder and the volume percentage of LP is the right volume percentage of spherical LP.[415]The powder or powder mixture according to any of [1] to [414], wherein the right volume percentage of spherical LP is 52 vol % or more.[416]The powder or powder mixture according to any of [1] to [415], wherein the right volume percentage of spherical LP is 61 vol % or more.[417]The powder or powder mixture according to any of [1] to [416], wherein the right volume percentage of spherical LP is 84 vol % or less.[418]The powder or powder mixture according to any of [1] to [417], wherein the right volume percentage of spherical LP is 79 vol % or less.[419]The method according to any of [1] to [418], wherein LP is a non-spherical powder and the volume percentage of LP is the right volume percentage of non-spherical LP.[420]The powder or powder mixture according to any of [1] to [419], wherein the right volume percentage of non-spherical LP is 41 vol % or more.[421]The powder or powder mixture according to any of [1] to [420], wherein the right volume percentage of non-spherical LP is 51 vol % or more.[422]The powder or powder mixture according to any of [1] to [421], wherein the right volume percentage of non-spherical LP is 79 vol % or less.[423]The powder or powder mixture according to any of [1] to [422], wherein the right volume percentage of non-spherical LP is 70 vol % or less.[424]The method according to any of [1] to [423], wherein the volume percentages are calculated taking into account only the metal comprising powders contained in the powder mixture.[425]The powder or powder mixture according to any of [1] to [424], wherein the powder size critical measure for LP is between 2 microns and 1990 microns.[426]The powder or powder mixture according to any of [1] to [425], wherein the powder size critical measure for LP is 22 microns or larger.[427]The powder or powder mixture according to any of [1] to [426], wherein the powder size critical measure for LP is 42 microns or larger.[428]The powder or powder mixture according to any of [1] to [427], wherein the powder size critical measure for LP is 1490 microns or smaller.[429]The powder or powder mixture according to any of [1] to [428], wherein the powder size critical measure for LP is 990 microns or smaller.[430]The powder or powder mixture according to any of [1] to [429], wherein the powder size critical measure for SP is between 0.6 nanometers and 990 microns.[431]The method according to any of [1] to [430], wherein the powder size critical measure for SP is 52 nanometers or larger.[432]The powder or powder mixture according to any of [1] to [431], wherein the powder size critical measure for SP is 602 nanometers or larger.[433]The powder or powder mixture according to any of [1] to [432], wherein the powder size critical measure for SP is 490 microns or smaller.[434]The powder or powder mixture according to any of [1] to [433], wherein the powder size critical measure for SP is 190 microns or smaller.[435]The powder or powder mixture according to any of [1] to [434], wherein the powder size critical measure is D50.[436]The powder or powder mixture according to any of [1] to [435], wherein the powder size critical measure is D10.[437]The powder or powder mixture according to any of [1] to [436], wherein the powder size critical measure is D90.[438]The powder or powder mixture according to any of [1] to [437], wherein D10 refers to a particle size at which 10% of the sample's volume is comprised of smaller particles in the cumulative distribution of particle size.[439]The powder or powder mixture according to any of [1] to [438], wherein D50 refers to a particle size at which 50% of the sample's volume is comprised of smaller particles in the cumulative distribution of particle size.[440]The powder or powder mixture according to any of [1] to [439], wherein D90 refers to a particle size at which 90% of the sample's volume is comprised of smaller particles in the cumulative distribution of particle size.[441]The powder or powder mixture according to any of [1] to [440], wherein particle size is measured by laser diffraction according to ISO 13320-2009.[442]The powder or powder mixture according to any of [1] to [504], wherein one of the powders in the mixture has a relevant difference in at least one element.[443]The powder or powder mixture according to any of [1] to [442], wherein one of the powders in the mixture has a relevant difference in at least 2 elements.[444]The powder or powder mixture according to any of [1] to [443], wherein one of the powders in the mixture has a relevant difference in at least 3 elements.[445]The powder or powder mixture according to any of [1] to [444], wherein one of the powders in the mixture has a relevant difference in at least 4 elements.[446]The powder or powder mixture according to any of [1] to [445], wherein one of the powders in the mixture has a relevant difference in at least 5 elements.[447]The powder or powder mixture according to any of [1] to [446], wherein a relevant difference is at least 20 wt % or more.[448]The powder or powder mixture according to any of [1] to [447], wherein a relevant difference is at least 60 wt % or more.[449]The powder or powder mixture according to any of [1] to [448], wherein a relevant difference is at least twice as much.[450]The powder or powder mixture according to any of [1] to [449], wherein a relevant difference is twenty times or less.[451]The powder or powder mixture according to any of [1] to [450], wherein a relevant difference is ten times or less.[452]The powder or powder mixture according to any of [1] to [451], wherein a relevant difference is 99 wt % or less.[453]The powder or powder mixture according to any of [1] to [452], wherein only relevantly present elements are taken into account.[454]The powder or powder mixture according to any of [1] to [453], wherein a relevantly present elements is an element present in a quantity of 0.012 wt % or more.[455]The powder or powder mixture according to any of [1] to [454], wherein a relevantly present elements is an element present in a quantity of 0.12 wt % or more.[456]The powder or powder mixture according to any of [1] to [455], wherein the element is Cr.[457]The powder or powder mixture according to any of [1] to [456], wherein the element is Mn.[458] The powder or powder mixture according to any of [1] to [457], wherein the element is V.[459]The powder or powder mixture according to any of [1] to [458], wherein the element is Ti.[460]The powder or powder mixture according to any of [1] to [459], wherein the element is Mo.[461]The powder or powder mixture according to any of [1] to [460], wherein the element is W.[462] The powder or powder mixture according to any of [1] to [461], wherein the element is Al.[463]The powder or powder mixture according to any of [1] to [462], wherein the element is Zr.[464]The powder or powder mixture according to any of [1] to [463], wherein the element is Si.[465]The powder or powder mixture according to any of [1] to [464], wherein the element is Sn.[466]The powder or powder mixture according to any of [1] to [465], wherein the element is Mg.[467]The powder or powder mixture according to any of [1] to [466], wherein the element is Cu.[468]The powder or powder mixture according to any of [1] to [467], wherein the element is C.[469]The powder or powder mixture according to any of [1] to [468], wherein the element is B.[470] The powder or powder mixture according to any of [1] to [469], wherein the element is N.[471]The powder or powder mixture according to any of [1] to [470], wherein the element is Ni.[472]The powder or powder mixture according to any of [1] to [471], wherein he powders in the mixture are chosen so that there is a considerable difference between the hardness of the softest powder and that of the hardest in the mixture.[473]The powder or powder mixture according to any of [1] to [472], wherein a considerable difference is 6 HV or more.[474]The powder or powder mixture according to any of [1] to [473], wherein a considerable difference is 12 HV or more.[475]The powder or powder mixture according to any of [1] to [474], wherein at least one relevant powder of the mixture is chosen with a low hardness of 289 HV or less.[476] A powder or powder mixture comprising a spherical LP powder, wherein the volume percentage of LP in the mixture is between 61 vol % and 84 vol %.[477] A powder or powder mixture comprising a non-spherical LP, wherein the volume percentage of LP in the mixture is between 51 vol % and 70 vol %.[478] A powder mixture comprising a water atomized LP powder and a gas atomized SP powder.[479] A powder mixture comprising a water atomized LP powder and a carbonyl iron powder.[480] A powder mixture comprising a water atomized LP powder and a SP powder obtained by oxide reduction.[481] A powder mixture comprising a water atomized LP powder and a SP powder obtained by oxide reduction and a carbonyl iron powder.[482] A powder mixture comprising a gas atomized LP powder and a gas atomized SP powder.[483]A method to manufacture a component comprising the following steps: —providing a metallic powder or metal comprising powder mixture comprising at least a spherical powder; —a forming step, wherein the component is formed by applying additive manufacturing method, wherein the additive manufacturing method comprises the use of an organic material; —applying a pressure and/or temperature treatment; —applying a debinding to eliminate at least part of the binder; —a consolidation step, wherein a consolidation treatment is applied; and —a densification step, wherein a high temperature, high pressure treatment is applied.[484]A method to manufacture a component comprising the following steps: —providing a metallic powder or metal comprising powder mixture comprising at least a non-spherical powder; —a forming step, wherein the component is formed by applying additive manufacturing method, wherein the additive manufacturing method comprises the use of an organic material: —applying a pressure and/or temperature treatment; —applying a debinding to eliminate at least part of the binder; —a consolidation step, wherein a consolidation treatment is applied: and —a densification step, wherein a high temperature, high pressure treatment is applied; [485] A method for manufacturing at least part of a metal comprising component, which method comprises the following steps: —providing a mold at least partly manufactured by additive manufacturing; —filling the mold with a powder or a powder mixture comprising a spherical LP powder, wherein the volume percentage of LP in the mixture is between 61 vol % and 84 vol %; —a forming step, wherein the component is formed by applying a pressure and/or temperature treatment to the mold; —a debinding step, wherein at least part of the mold is eliminated: —a consolidation step, wherein a consolidation treatment is applied, wherein the maximum temperature applied in the consolidation treatment is above 0.85*Tm; —a densification step, wherein a high temperature, high pressure treatment is applied; and —optionally, applying a heat treatment and/or machining.[486] A powder or powder mixture comprising a non-spherical LP powder, wherein the volume percentage of LP in the mixture is between 61 vol % and 84 vol %, and carbonyl iron powder, wherein the volume percentage of the carbonyl iron powder in the mixture is between 20 wt % and 50%.[487] A method for manufacturing at least part of a metal comprising component, which method comprises the following steps: —providing a mold at least partly manufactured by additive manufacturing; —filling the mold with a powder or a powder mixture comprising a non-spherical LP powder, wherein the volume percentage of LP in the mixture is between 61 vol % and 84 vol %, and carbonyl iron powder, wherein the volume percentage of the carbonyl iron powder in the mixture is between 20 vol % and 50 vol %; —a forming step, wherein the component is formed by applying a pressure and/or temperature treatment to the mold; —a debinding step, wherein at least part of the mold is eliminated; —a consolidation step, wherein a consolidation treatment is applied, wherein the maximum temperature applied in the consolidation treatment is above 0.85*Tm; —a densification step, wherein a high temperature, high pressure treatment is applied; and —optionally, applying a heat treatment and/or machining.[488] A powder mixture comprising a LP powder, wherein the volume percentage of LP in the mixture is above 46 vol % and below 89 vol %, wherein the % C in the LP is at low interstitial content level; wherein the powder mixture comprises a carbonyl iron powder, wherein the volume percentage of the carbonyl iron powder in the mixture is between 1 vol % and 40 vol %.[489] A powder mixture comprising a gas atomized LP powder and a carbonyl iron powder.[490] A powder mixture comprising a gas atomized LP powder and a SP powder obtained by oxide reduction.[491] A powder mixture comprising a gas atomized LP powder, a SP powder obtained by oxide reduction and a carbonyl iron powder.[492]A method to manufacture a component comprising the following steps: —providing a metallic powder or metal comprising powder mixture comprising at least a spherical LP powder, wherein the volume percentage of LP in the mixture is between 61 vol % and 84 vol %; wherein the powder mixture comprises a carbonyl iron powder, wherein the volume percentage of the carbonyl iron powder in the mixture is above 10 vol %; —a forming step, wherein the component is formed by applying additive manufacturing method, wherein the additive manufacturing method comprises the use of an organic material; —applying a pressure and/or temperature treatment; wherein the pressure is applied in an homogeneous way; —applying a debinding to eliminate at least part of the binder; —a consolidation step, wherein a consolidation treatment is applied; wherein the maximum temperature applied in the consolidation treatment is above 0.85*Tm; and —a densification step, wherein a high temperature, high pressure treatment is applied.[493] A method for manufacturing at least part of a metal comprising component, which method comprises the following steps: —providing a mold at least partly manufactured by additive manufacturing; —filling the mold with a powder or a powder mixture comprising at least a spherical LP powder, wherein the volume percentage of LP in the mixture is between 61 vol % and 84 vol %; wherein the powder mixture comprises a carbonyl iron powder, wherein the volume percentage of the carbonyl iron powder in the mixture is above 10 vol %: —a forming step, wherein the component is formed by applying a pressure and/or temperature treatment to the mold; wherein the pressure is applied in an homogeneous way: —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining.[494] A method for manufacturing at least part of a metal comprising component, which method comprises the following steps: —providing a mold at least partly manufactured by additive manufacturing; —filling the mold with a powder or a powder mixture comprising at least a spherical LP powder, wherein the volume percentage of LP in the mixture is between 61 vol % and 84 vol %: wherein the powder mixture comprises a carbonyl iron powder, wherein the volume percentage of the carbonyl iron powder in the mixture is 10 vol % or more; —a forming step, wherein the component is formed by applying a pressure and/or temperature treatment to the mold; —a debinding step, wherein at least part of the mold is eliminated; —a consolidation step, wherein a consolidation treatment is applied, wherein the temperature applied in the consolidation treatment is above 0.85*Tm; —a densification step, wherein a high temperature, high pressure treatment is applied; and —optionally, applying a heat treatment and/or machining.[495] A method to manufacture a component comprising the following steps: —providing a powder or powder mixture comprising a carbonyl iron powder; —applying additive manufacturing method, wherein the additive manufacturing method is selected from binder jetting (BJ) and/or fused filament fabrication (FFF): —applying a debinding to eliminate at least part of the organic material; —a fixing step, wherein the oxygen and/or nitrogen level of the metallic part of the component is set; —a consolidation step, wherein a consolidation treatment is applied; and —a densification step, wherein a high temperature, high pressure treatment is applied. [496] A method to manufacture a component comprising the following steps: —providing a powder or powder mixture comprising a carbonyl iron powder: —a forming step, wherein an additive manufacturing method is applied to form the component, wherein the additive manufacturing method is selected from binder jetting (BJ) and/or fused filament fabrication (FFF); —a debinding step, wherein at least part of the organic material is eliminated; —a fixing step, wherein the oxygen and/or nitrogen level of the metallic part of the component is set; —a consolidation step, wherein a consolidation treatment is applied; and —a densification step, wherein a high temperature, high pressure treatment is applied; wherein the significant cross-section of the component is 0.79 times or less the area of the largest rectangular face of the rectangular cuboid with the minimum possible volume which contains the component; wherein the component comprises fine channels with a cross section between 1.13 mm² and 50 mm², and at least one inlet collector and one outlet collector connected by more than one fine channel with a temperature gradient within the collector below 39° C. [497] A method to manufacture a component comprising the following steps: —providing a powder or powder mixture comprising a carbonyl iron powder; —a forming step, wherein an additive manufacturing method is applied to form the component, wherein the additive manufacturing method is selected from binder jetting (BJ) and/or fused filament fabrication (FFF); —applying a pressure and/or temperature treatment; —a debinding step, wherein at least part of the organic material is eliminated; —a fixing step, wherein the oxygen and/or nitrogen level of the metallic part of the component is set; —a consolidation step, wherein a consolidation treatment is applied; and —a densification step, wherein a high temperature, high pressure treatment is applied; [498] A method to manufacture a component comprising the following steps: —providing a powder or powder mixture comprising a carbonyl iron powder; —a forming step, wherein an additive manufacturing method is applied to form the component, wherein the additive manufacturing method is selected from binder jetting (BJ) and/or fused filament fabrication (FFF): —a debinding step, wherein at least part of the organic material is eliminated; —applying a pressure and/or temperature treatment; wherein the pressure is applied in an homogeneous way; —a fixing step, wherein the oxygen and/or nitrogen level of the metallic part of the component is set; —a consolidation step, wherein a consolidation treatment is applied; and —a densification step, wherein a high temperature, high pressure treatment is applied; wherein the heating in the pressure and/or temperature treatment is at least partially made with microwaves. [499] A method to manufacture a component comprising the following steps: —providing a powder or powder mixture comprising a carbonyl iron powder; —a forming step, wherein an additive manufacturing method is applied to form the component, wherein the additive manufacturing method is selected from binder jetting (BJ) and/or fused filament fabrication (FFF); —applying a pressure and/or temperature treatment; wherein the pressure is applied in an homogeneous way; —a debinding step, wherein at least part of the organic material is eliminated; —a fixing step, wherein the oxygen and nitrogen level of the metallic part of the component is set; —a consolidation step, wherein a consolidation treatment is applied; and —a densification step, wherein a high temperature, high pressure treatment is applied: wherein the heating in the pressure and/or temperature treatment is at least partially made with microwaves. [500] The Method according to any of [1] to [499], wherein the pressure and/or temperature treatment comprises a heating with microwaves, wherein the frequency employed is 2.45 GHz +/−250 Mhz, wherein the fluid used to apply pressure comprises a fluid with a polarity between 0.006 and 3.99. [501] The Method according to any of [1] to [500], wherein the pressure and/or temperature treatment comprises a heating with microwaves, wherein the frequency employed is 2.45 GHz +/−250 Mhz and the total power is above 55 W and wherein the fluid used to apply pressure comprises a fluid with a polarity of 0.011 or more. [502]The method according to any of [1] to [501], wherein the high temperature, high pressure treatment is applied to a component with a % NMVS between 0.02% and 2% and a % NMVC above 6%, wherein the high temperature high pressure treatment comprises a heating with microwaves heating with microwaves which is performed in a pressurized chamber comprising a mobile system and at least 1 applicator or antenna and less than 59 applicators or antennas: wherein the pressurized chamber comprises a coaxial feed-trough with an impedance between 21 Ohms and 99 Ohms. [503]The method according to any of [1] to [502], wherein the high temperature, high pressure treatment is applied to a component with a % NMVS between 0.02% and 2% and a % NMVC above 6%, wherein the high temperature high pressure treatment comprises a heating with microwaves which is performed in a pressurized chamber comprising a mobile system and at least 1 applicator or antenna and less than 59 applicators or antennas; wherein the pressurized chamber comprises a coaxial feed-trough with an impedance between 21 Ohms and 99 Ohms; wherein the pressurized chamber comprises an element supporting glowing materials and glowing materials with a dielectric loss between 10.49 and 199. [504]A method to manufacture a component comprising the following steps: —providing a metallic powder or metal comprising powder mixture wherein the powder or powder mixture mean composition, has the following compositional range, all percentages being indicated in weight percent: % Mo: 0-6.8; % W: 0-6.9; % Moeq: 0-6.8; % Ceq: 0.16-1.8; % C: 0-1.29; % N: 0.11-2.09; % B: 0-0.14; % Si: 0-1.5; % Mn: 0-24; % Ni: 0-18.9; % Cr: 12.1-38; % Ti: 0-2.4:% Al: 0-14; % V: 0-4:% Nb: 0-4:% Zr: 0-3:% Hf: 0-3; % Ta: 0-3; % S: 0-0.098; % P: 0-0.098; % Pb: 0-0.9; % Cu: 0-3.9; % Bi: 0-0.08; % Se: 0-0.08: % Co: 0-14: % REE: 0-4; % Y: 0-1.86; % Sc: 0-0.96; % Cs: 0-1.4; % O: 0.00012-0.899; % Y+% Sc+% REE: 0.0022-3.9%; the rest consisting of iron and trace elements: wherein % Ceq=% C+0.86*% N+1.2*% B and % Moeq=% Mo+½*% W; —a forming step, wherein an additive manufacturing method is applied to form the component; —a debinding step; —a fixing step, wherein the oxygen level of the metallic part of the component is set to more than 260 ppm and less than 19000 ppm a consolidation step, wherein a consolidation treatment is applied; and —optionally, a densification step, wherein a high temperature, high pressure treatment is applied; wherein the % O in the component complies with the formula % O≤KYS*(% Y+1.98*% Sc+0.67*% REE), being KYS=2350. [504]A method to manufacture a component comprising the following steps: —providing a metallic powder or metal comprising powder mixture comprising a carbonyl iron powder; —a forming step, wherein an additive manufacturing method is applied to form the component; —optionally, a debinding step; —a fixing step, wherein the oxygen and/or nitrogen level of the metallic part of the component is set —a consolidation step, wherein a consolidation treatment is applied; and —optionally, a densification step, wherein a high temperature, high pressure treatment is applied; wherein the volume of the component is more than 2% and less than 89% of the volume of the rectangular cuboid with the minimum possible volume which contains the component; wherein the component comprises fine channels, wherein the distance from the fine channels to the surface to be thermo-regulated is between 0.6 mm and 32 mm: wherein the equivalent diameter of the fine channels is between 0.1 mm to 128 mm; wherein the number of fine channels per square meter of thermo-regulated surface is between 21 and 14000; wherein the fluid flows in the fine channels in such a way that the mean Reynolds number is maintained greater than 810 and less than 89000 and wherein the rugosity of the channels is at least 0.9 microns and less than 190 microns.[505] A method for manufacturing at least part of a metal comprising component, which method comprises the following steps: —providing a mold at least partly manufactured by additive manufacturing; —filling the mold with a powder or a powder mixture comprising a carbonyl iron powder; —a forming step, wherein the component is formed by applying a pressure and/or temperature treatment to the mold; —a debinding step, wherein at least part of the mold is eliminated; —a consolidation step, wherein a consolidation treatment is applied; —a densification step, wherein a high temperature, high pressure treatment is applied; and —optionally, applying a heat treatment and/or machining; wherein the component comprises fine channels with a H value greater than 12 and less than 230, being H=the total length of the fine channels/the mean length of the fine channels: wherein the equivalent diameter of the fine channels is between 1.2 mm and 18 mm; wherein the number of fine channels per square meter of thermo-regulated surface is between 61 and 4000: wherein the component comprises at least one inlet collector and one outlet collector connected by more than one fine channel with a temperature gradient within the collector below 9° C. and wherein the mean cross-section of the component is more than 0.2 mm² and less than 2900000 mm², wherein the 20% of the largest cross-sections and the 20% of the smallest cross-sections are not considered to calculate the mean cross-section. [506]A method for manufacturing at least part of a metal comprising component, which method comprises the following steps: —providing a powder or powder mixture a powder or a powder mixture comprising a carbonyl iron powder: —a forming step, wherein the component from the powder or powder mixture comprising at least a metal or a metal alloy in powdered form using a metal additive manufacturing (MAM) method is formed, wherein the MAM method comprises the use of an organic material: —a debinding step, wherein at least part of the organic material is eliminated; —a consolidation step, wherein a consolidation treatment is applied; —a densification step, wherein a high temperature, high pressure treatment is applied; and —optionally, applying a heat treatment and/or machining; wherein the component comprises fine channels and main channels; wherein the mean cross-section of the main channels is at least 3 times higher than the cross-section of the smallest channel among all the fine channels in the component area where the thermo-regulation is desired: wherein the number of fine channels per square meter of thermo-regulated surface is between 61 and 4000: wherein the rugosity of the channels is at least 10.2 microns and less than 98 microns and wherein the wherein largest cross-section of the component is more than 0.2 mm² and 0.59 times or less the area of the largest rectangular face of the rectangular cuboid with the minimum possible volume which contains the component and wherein the largest cross-section of the component is the largest cross section obtained after excluding the 40% of the largest cross-sections.[507]A method to manufacture a component comprising the following steps: —providing a powder or a powder mixture comprising a carbonyl iron powder —a forming step, wherein an additive manufacturing method is applied to form the component; —a fixing step, wherein the oxygen and/or nitrogen level of the metallic part of the component is set; —a consolidation step, wherein a consolidation treatment is applied; and —optionally, a densification step, wherein a high temperature, high pressure treatment is applied: wherein the component comprises fine channels and main channels; wherein the rugosity of the channels is at least 10.2 microns and less than 98 microns and wherein the significant cross-section of the component is 0.79 times or less the area of the largest rectangular face of the rectangular cuboid with the minimum possible volume which contains the component. [508]A method to manufacture a component comprising the following steps: —providing a metallic powder or metal comprising powder mixture wherein the powder or powder mixture mean composition, has the following compositional range, all percentages being indicated in weight percent: % Mo: 0-6.8; % W: 0-6.9; % Moeq: 0-6.8; % Ceq: 0.16-1.8; % C: 0-1.29; % N: 0.11-2.09; % B: 0-0.14; % Si: 0-1.5; % Mn: 0-24; % Ni: 0-18.9; % Cr: 12.1-38; % Ti: 0-2.4; % Al: 0-14; % V: 0-4; % Nb: 0-4; % Zr: 0-3; % Hf: 0-3; % Ta: 0-3; % S: 0-0.098; % P: 0-0.098; % Pb: 0-0.9; % Cu: 0-3.9; % Bi: 0-0.08: % Se: 0-0.08; % Co: 0-14: % REE: 0-4; % Y: 0-1.86; % Sc: 0-0.96; % Cs: 0-1.4; % O: 0.00012-0.899; % Y+% Sc+% REE: 0.0022-3.9%: the rest consisting of iron and trace elements: wherein % Ceq-% C+0.86*% N+1.2*% B and % Moeq-% Mo+½*% W; —a forming step, wherein an additive manufacturing method is applied to form the component; —a debinding step; —a fixing step, wherein the oxygen level of the metallic part of the component is set to more than 520 ppm: —a consolidation step, wherein a consolidation treatment is applied; and —optionally, a densification step, wherein a high temperature, high pressure treatment is applied; wherein the % O in the component complies with the formula % O≤KYS*(% Y+1.98*% Sc+0.67*% REE), being KYS=2350. [509]A method to manufacture a component comprising the following steps: —providing a metallic powder or metal comprising powder mixture comprising a carbonyl iron powder; —a forming step, wherein an additive manufacturing method is applied to form the component; —optionally, a debinding step; —a fixing step, wherein the oxygen and/or nitrogen level of the metallic part of the component is set —a consolidation step, wherein a consolidation treatment is applied; and —optionally, a densification step, wherein a high temperature, high pressure treatment is applied: wherein the volume of the component is more than 2% and less than 89% of the volume of the rectangular cuboid with the minimum possible volume which contains the component. [509]A method for manufacturing at least part of a metal comprising component, which method comprises the following steps: —providing a mold at least partly manufactured by additive manufacturing; —filling the mold with a powder or a powder mixture comprising a carbonyl iron powder; —a forming step, wherein the component is formed by applying a pressure and/or temperature treatment to the mold; wherein the pressure and/or temperature treatment comprises applying the in a homogeneous way —a debinding step, wherein at least part of the mold is eliminated; —a consolidation step, wherein a consolidation treatment is applied: —a densification step, wherein a high temperature, high pressure treatment is applied; and —optionally, applying a heat treatment and/or machining: wherein the volume of the component is 0.79 times or less the volume of the rectangular cuboid with the minimum possible volume which contains the component. [508]A method to manufacture a component comprising the following steps: —providing a powder or powder mixture comprising a non-spherical LP powder, wherein the volume percentage of LP in the mixture is between 61 vol % and 84 vol %, and carbonyl iron powder, wherein the volume percentage of the carbonyl iron powder in the mixture is between 20 vol % and 50 vol %.; —a forming step, wherein an additive manufacturing method is applied to form the component; —a debinding step: —a fixing step, wherein the oxygen and/or nitrogen level of the metallic part of the component is set; —a consolidation step, wherein a consolidation treatment is applied; and —optionally, a densification step, wherein a high temperature, high pressure treatment is applied. [509]A method to manufacture a component comprising the following steps: —providing a powder or powder mixture comprising a non-spherical LP powder, wherein the volume percentage of LP in the mixture is between 61 vol % and 84 vol %, and carbonyl iron powder, wherein the volume percentage of the carbonyl iron powder in the mixture is between 20 vol % and 50 vol %.; —a forming step, wherein an additive manufacturing method is applied to form the component; —a debinding step; —a fixing step, wherein the oxygen and/or nitrogen level of the metallic part of the component is set: —a consolidation step, wherein a consolidation treatment is applied; and —optionally, a densification step, wherein a high temperature, high pressure treatment is applied. [510]A method to manufacture a component comprising the following steps: —providing a powder or powder mixture comprising a non-spherical LP powder, wherein the volume percentage of LP in the mixture is between 61 vol % and 84 vol %, and carbonyl iron powder, wherein the volume percentage of the carbonyl iron powder in the mixture is between 20 wt % and 50%.; —a forming step, wherein an additive manufacturing method is applied to form the component: —a fixing step, wherein the oxygen and/or nitrogen level of the metallic part of the component is set; —a consolidation step, wherein a consolidation treatment is applied; and —optionally, a densification step, wherein a high temperature, high pressure treatment is applied.[511]A powder or powder mixture comprising a non-spherical powder and carbonyl iron powder, wherein the volume percentage of the carbonyl iron powder in the mixture is between 10 vol % and 50 vol %.[512]A powder mixture comprising a carbonyl iron powder, wherein the volume percentage of the carbonyl iron powder in the mixture is between 10 vol % and 50 vol %.[513]A powder or powder mixture comprising a spherical powder and carbonyl iron powder, wherein the volume percentage of the carbonyl iron powder.[514]A powder or powder mixture comprising a spherical powder and carbonyl iron powder, wherein the volume percentage of the carbonyl iron powder in the mixture is 10 vol % or more.[515]A powder or powder mixture comprising a powder obtained by oxide reduction.[516]A powder or powder mixture comprising a gas atomized powder.[517]A powder or powder mixture comprising a centrifugal atomized powder.[518]A powder or powder mixture comprising a powder obtained by gas atomization a powder obtained by water atomization.[519]A powder or powder mixture comprising a water atomized powder.[520]A powder or powder mixture comprising a gas atomized powder and a carbonyl iron powder.[521]A powder or powder mixture comprising a centrifugal atomized powder and a carbonyl iron powder.[522]A powder or powder mixture comprising a powder obtained by gas atomization a powder obtained by water atomization and a carbonyl iron powder.[523]A powder or powder mixture comprising a water atomized powder and a carbonyl iron powder.[524]A powder or powder mixture comprising a gas atomized powder and a carbonyl iron powder wherein the volume percentage of the carbonyl iron powder in the mixture is between 10 vol % and 50 vol %.[515]A powder or powder mixture comprising a centrifugal atomized powder and a carbonyl iron powder, wherein the volume percentage of the carbonyl iron powder in the mixture is between 10 vol % and 50 vol %.[525]The method according to any of [1] to [524], wherein the consolidation treatment is applied to the component obtained after the debinding step.[526]The method according to any of [1] to [525], wherein the consolidation treatment is applied to the component obtained after applying the pressure and/or temperature treatment.[527]The method according to any of [1] to [526], wherein the consolidation treatment is applied to the component obtained after the fixing step.[528]The method according to any of [1] to [527], wherein the high temperature, high pressure treatment is applied to the component obtained after the fixing step.[529]The method according to any of [1] to [528], wherein the high temperature, high pressure treatment is applied to the component obtained after the debinding.[530]The method according to any of [1] to [529], wherein the high temperature, high pressure treatment is applied to the component obtained after the consolidation step.[531]The method according to any of [1] to [530], wherein the high temperature, high pressure treatment is applied to the component obtained after the pressure and/or temperature treatment.[532]The method according to any of [1] to [531], wherein “a powder or powder mixture comprising at least a metal or a metal alloy in powdered form” is replaced by “a powder or powder mixture”.[533]The method according to any of [1] to [532], wherein “a powder or powder mixture comprising at least a metal or a metal alloy in powdered form” is replaced by “a powder”.[534]The method according to any of [1] to [533], wherein “a powder or powder mixture comprising at least a metal or a metal alloy in powdered form” is replaced by “a powder mixture”.[535]The method according to any of [1] to [534], wherein “a metallic powder or metal comprising powder mixture” is replaced by “a powder or powder mixture”.[536]The method according to any of [1] to [535], wherein “a metallic powder or metal comprising powder mixture” is replaced by “a powder”.[537]The method according to any of [1] to [536], wherein “a metallic powder or metal comprising powder mixture” is replaced by “a powder mixture”.[538]The method according to any of [1] to [537], wherein “a powder or powder mixture comprising at least a metal or a metal alloy in powdered form” is replaced by “a metallic powder or metal comprising powder mixture”. [539]The method according to any of [1] to [538], wherein the metallic powder or metal comprising powder mixture is a powder mixture comprising at least a metal or a metal alloy in powdered form.[540]The method according to any of [1] to [539], wherein the oxygen content of the powder or powder mixture is more than 250 ppm and loss than 48000 ppm.[541]The method according to any of [1] to [540], wherein the oxygen content of the powder or powder mixture is more than 250 ppm.[542]The method according to any of [1] to [541], wherein the oxygen content of the powder or powder mixture is more than 620 ppm.[543]The method according to any of [1] to [542], wherein the oxygen content of the powder or powder mixture is more than 1100 ppm and less than 48000 ppm.[544]The method according to any of [1] to [543], wherein the oxygen content of the powder or powder mixture is less than 48000 ppm.[545]The method according to any of [1] to [544], wherein the oxygen content of the powder or powder mixture is less than 19000 ppm.[546]The method according to any of [1] to [545], wherein the oxygen content of the powder or powder mixture is less than 9000 ppm.[547]The method according to any of [1] to [546], wherein the oxygen content of the powder or powder mixture is more than 620 ppm and less than 9000 ppm.[548]The method according to any of [1] to [547], wherein the oxygen content refers to the oxygen content in at least one of the powders comprised in the powder mixture.[549]The method according to any of [1] to [548], wherein the oxygen content refers to the oxygen content in in the powder.[550]The method according to any of [1] to [549], wherein the oxygen content refers to the oxygen content of the powder mixture.[551]The method according to any of [1] to [550], wherein the powder mixture comprises at least a powder with an oxygen content of more than 250 ppm and less than 48000 ppm.[552]The method according to any of [1] to [551], wherein the powder comprises at least a powder with an oxygen content of more than 620 ppm.[553]The method according to any of [1] to [552], wherein the powder mixture comprises at least a powder with an oxygen content of more than 620 ppm and less than 19000 ppm.[554]The method according to any of [1] to [553], wherein the powder mixture comprises at least a powder with an oxygen content of less than 19000 ppm.[555]The method according to any of [1] to [554], wherein, the nitrogen content of the powder or powder mixture is more than 12 ppm. [556]The method according to any of [1] to [555], wherein, the nitrogen content of the powder or powder mixture is less than 9000 ppm.[557]The method according to any of [1] to [556], wherein, the nitrogen content of the powder or powder mixture is more than 12 ppm and less than 9000 ppm.[558]The method according to any of [1] to [557], wherein, the nitrogen content of the powder or powder mixture is more than 55 ppm and less than 9000 ppm.[559]The method according to any of [1] to [558], wherein, the nitrogen content of the powder or powder mixture is less than 900 ppm.[560]The method according to any of [1] to [559], wherein the nitrogen content refers to the nitrogen content in at least one of the powders comprised in the powder mixture.[561]The method according to any of [1] to [560], wherein the nitrogen content refers to the nitrogen content of the powder mixture.[562]The method according to any of [1] to [561], wherein the oxygen content refers to the oxygen content in in the powder.[563]The method according to any of [1] to [562], wherein, the powder mixture comprises at least a powder with a nitrogen content of more than 12 ppm.[564]The method according to any of [1] to [563], wherein the powder mixture comprises at least one powder with a nitrogen content of more than 12 ppm and less than 9000 ppm.[565]The method according to any of [1] to [564], wherein, the powder mixture comprises at least a powder with a nitrogen content of more than 55 ppm.[566]The method according to any of [1] to [565], wherein the powder mixture comprises at least one powder with a nitrogen content of more than 55 ppm and less than 9000 ppm.[567]The method according to any of [1] to [566], wherein the powder mixture comprises at least one powder with a nitrogen content of less than 900 ppm.[568]The method according to any of [1] to [567], wherein at least one powder in the powder mixture has the composition of a nitrogen austenitic steel.[569]The method according to any of [1] to [568], wherein the powder has the composition of a nitrogen austenitic steel.[570]The method according to any of [1] to [569], wherein the powder mixture has the composition of a nitrogen austenitic steel.[571]The method according to any of [1] to [570], wherein the powder or powder mixture comprises % V+% Al+% Cr+% Mo+% Ta+% W+% Nb in a content of 0.12 wt/o or higher.[572]The method according to any of [1] to [571], wherein the powder or powder mixture comprises % V+% Al+% Cr+% Mo+% Ta+% W+% Nb in a content of 34 wt % or lower.[573]The method according to any of [1] to [572], wherein the powder or powder mixture comprises at least one of % V, % Al, % Cr, % Mo, % Ta, % W and/or % Nb.[574]The method according to any of [1] to [573], wherein the powder or powder mixture comprises at least one of: % Y, % Sc and/or % REE.[575]The method according to any of [1] to [574], wherein the powder or powder mixture comprises at least one of: % Y, % Sc, % REE and/or % Ti.[576]The method according to any of [1] to [575], wherein the powder or powder mixture comprises a % Y+% Sc+% REE content from 0.012 wt % to 6.8 wt %.[577]The method according to any of [1] to [576], wherein the powder or powder mixture comprises a % Ti+% Y+% Sc+% REE content from 0.012 wt % to 6.8 wt %.[578]The method according to any of [1] to [577], wherein the % Yeq(1) content in the powder or powder mixture is higher than 0.03 wt % and lower than 8.9 wt %.[579]The method according to any of [1] to [578], wherein the % Yeq(1) content in the powder or powder mixture is higher than 0.06 wt %.[580]The method according to any of [1] to [579], wherein the % Yeq(1) content in the powder or powder mixture is higher than 1.2 wt %.[581]The method according to any of [1] to [580], wherein the % Yeq(1) content is the % Yeq(1) content in at least one of the powders comprised in the powder mixture.[582]The method according to any of [1] to [581], wherein the % Yeq(1) content is the % Yeq(1) content in powder mixture.[583]The method according to any of [1] to [582], wherein the % Yeq(1) content is the % Yeq(1) content in the powder.[584]The method according to any of [1] to [583], wherein the nitrogen content of the powder or powder mixture is more than 55 ppm and less than 9000 ppm. [585]The method according to any of [1] to [584], wherein the powder mixture comprises at least a powder with a nitrogen content of more than 55 ppm and less than 9000 ppm.[586]The method according to any of [1] to [585], wherein the % O in the powder or powder mixture complies with the formula % O≤KYS*(% Y+1.98*% Sc+2.47*% Ti+0.67*% REE).[587]The method according to any of [1] to [586], wherein the % O in the powder or powder mixture complies with the formula % O≤KYS*(% Y+1.98*% Sc+0.67*% REE).[588]The method according to any of [1] to [587], wherein the oxygen content refers to the % O content of the powder mixture.[589]The method according to any of [1] to [588], wherein the oxygen content refers to the % O content in at least one of the powders comprised in the powder mixture.[590]The method according to any of [1] to [589], wherein a powder is used.[591]The method according to any of [1] to [590], wherein a powder mixture is used.[592]The method according to any of [1] to [591], wherein the powder is a metallic powder.[593]The method according to any of [1] to [592], wherein the powder is a powder comprising at least a metal or a metal alloy in powdered form.[594]The method according to any of [1] to [593], wherein the powder mixture is a powder mixture comprising at least a metal or a metal alloy in powdered form.[595]The method according to any of [1] to [594], wherein the powder mixture is a metal comprising powder mixture.[596]The method according to any of [1] to [595], wherein the filled mold is sealed.[597]The method according to any of [1] to [596], wherein the mold is sealed with a polymeric film.[598]The method according to any of [1] to [597], wherein a coating is applied to the filled mold.[599]The method according to any of [1] to [598] wherein an organic coating is applied to at least part of the mold.[600]The method according to any of [1] to [599] wherein the coating comprises a polymer.[601]The method according to any of [1] to [600] wherein the coating comprises an elastomer.[602]The method according to any of [1] to [601] wherein the coating comprises a rubbery material.[603]The method according to any of [1] to [602] wherein the coating comprises latex.[604]The method according to any of [1] to [603] wherein the coating comprises a silicone.[605]The method according to any of [1] to [604] wherein the coating is a vacuum bag that is placed over the filled mold.[606]The method according to any of [1] to [605] wherein, the coating is used as a vacuum container to retain the vacuum in the mold.[607]The method according to any of [1] to [606] wherein the mold is sealed in a vacuum tight way.[608]The method according to any of [1] to [607] wherein the mold is sealed with a low leak rate.[609]The method according to any of [1] to [608] wherein a low leak rate is 0.9 mbar·l/s or less.[610]The method according to any of [1] to [609] wherein a low leak rate is 0.08 mbar·l/s or less.[611]The method according to any of [1] to [610] wherein a low leak rate is 0.008 mbar·l/s or less.[612] The method according to any of [1] to [611] wherein a low leak rate is 0.0008 mbar·l/s or less.[613]The method according to any of [1] to [612] wherein a low leak rate is 1.2·10⁻⁸ mbar·l/s or more.[614]The method according to any of [1] to [613] wherein a low leak rate is 1.2·10⁻⁷ mbar·l/s or more.[615]The method according to any of [1] to [614] wherein a low leak rate is 1.2·10⁻⁶ mbar·l/s or more.[616]The method according to any of [1] to [615] wherein leak rate is measured according to DIN-EN 1330-8.[617]The method according to any of [1] to [616] wherein leak rate is measured according to DIN-EN 13185:2001.[618]The method according to any of [1] to [617] wherein the vacuum made is 10⁻⁸ mbar or more.[619]The method according to any of [1] to [618] wherein the vacuum made is 10⁻⁶ mbar or more.[620]The method according to any of [1] to [619] wherein the vacuum made is 790 mbar or more.[621]The method according to any of [1] to [620] wherein the vacuum made is 490 mbar or more.[622]The method according to any of [1] to [621] wherein the vacuum made is 90 mbar or more.[623]The method according to any of [1] to [622] wherein the vacuum made 490 mbar or less.[624]The method according to any of [1] to [623] wherein the vacuum made is 0.0009 mbar or less.[625]The method according to any of [1] to [624], wherein the additive manufacturing technology used to manufacture the mold in the forming step comprises form the component layer by layer.[626]The method according to any of [1] to [625], wherein the additive manufacturing technology used to manufacture the mold in the forming step is a non-additive manufacturing method.[627]The method according to any of [1] to [626], wherein the additive manufacturing technology used to manufacture the mold in the forming step is PlM.[628]The method according to any of [1] to [627], wherein the AM method used to manufacture the mold is selected from: fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS), selective heat sintering (SHS), direct energy deposition (DeD), big area additive manufacturing (BAAM) and/or combinations thereof.[629]The method according to any of [1] to [628], wherein the AM method used to manufacture the mold is FDM.[630]The method according to any of [1] to [629], wherein the AM method used to manufacture the mold is FFF.[631]The method according to any of [1] to [630], wherein the AM method used to manufacture the mold is DLS.[632]The method according to any of [1] to [631], wherein the AM method used to manufacture the mold is a technology based on CLIP.[633]The method according to any of [1] to [632], wherein the AM method used to manufacture the mold is SLA.[634]The method according to any of [1] to [633], wherein the AM method used to manufacture the mold is DLP.[635]The method according to any of [1] to [634], wherein the AM method used to manufacture the mold is SHS.[636]The method according to any of [1] to [635], wherein the AM method used to manufacture the mold is SLS.[637]The method according to any of [1] to [636], wherein the AM method used to manufacture the mold is BJ.[638]The method according to any of [1] to [637], wherein the AM method used to manufacture the mold is MJ.[639]The method according to any of [1] to [638], wherein the AM method used to manufacture the mold is DOD.[640]The method according to any of [1] to [639], wherein the AM method used to manufacture the mold is MJF.[641]The method according to any of [1] to [640], wherein the AM method used to manufacture the mold is DeD.[642]The method according to any of [1] to [641], wherein the AM method used to manufacture the mold is CDLP.[643]The method according to any of [1] to [642], wherein the AM method used to manufacture the mold is BAAM.[644]The method according to any of any of [1] to [643], wherein at least two different AM methods are used to manufacture the mold.[645]The method according to any of [1] to [644], wherein the mold is manufactured in different pieces that are assembled together.[646]The method according to any of [1] to [645], wherein the mold is manufactured with 3 or more different pieces assembled together.[647]The method according to any of [1] to [646], wherein at least one of the pieces that are assembled to fabricate the mold is provided with a guiding mechanism that fixes the orientation with respect of at least one of the pieces to which it is assembled.[648]The method according to any of [1] to [647], wherein the mold comprises an elastomer.[649]The method according to any of [1] to [648], wherein the mold comprises PPS.[650]The method according to any of [1] to [649], wherein mold comprises PEEK.[651]The method according to any of [1] to [650], wherein the mold comprises Pl [652]The method according to any of [1] to [651], wherein the mold is comprises viton.[653]The method according to any of [1] to [652] wherein the mold comprises a thermosetting polymer.[654]The method according to any of [1] to [653] wherein the mold comprises a thermoplastic polymer.[655]The method according to any of [1] to [654] wherein the mold comprises an amorphous polymer.[656]The method according to any of [1] to [655] wherein the mold comprises PS.[657]The method according to any of [1] to [656] wherein the mold comprises PCL.[658]The method according to any of [1] to [657] wherein the mold comprises porous PCL.[659]The method according to any of [1] to [658] wherein the mold comprises PA.[660]The method according to any of [1] to [659] wherein the mold comprises HDPE and/or LDHE.[661]The method according to any of [1] to [660] wherein the mold comprises PP.[662]The method according to any of [1] to [661] wherein the mold comprises amorphous PP.[663]The method according to any of [1] to [662], wherein the mold comprises PVA.[664]The method according to any of [1] to [663], wherein the mold comprises Kollidon VA64. [665]The method according to any of [1] to [664], wherein the mold comprises Kollidon 12 PF.[666]The method according to any of [1] to [665], wherein the mold comprises a polymer comprising an aromatic group.[667]The method according to any of [1] to [666], wherein the mold comprises polymethyl methacrylate.[668] The method according to any of [1] to [667], wherein the mold comprises a copolymer comprising acrylonitrile.[669]The method according to any of [1] to [668], wherein the mold comprises a copolymer comprising styrene.[670]The method according to any of [1] to [669], wherein the mold comprises ABS.[671]The method according to any of [1] to [670], wherein the mold comprises SAN.[672]The method according to any of [1] to [671], wherein the mold comprises PC.[673]The method according to any of [1] to [672], wherein the mold comprises PPO.[674]The method according to any of [1] to [673], wherein the mold comprises a vinylic polymer.[675]The method according to any of [1] to [674], wherein the mold comprises PVC.[676]The method according to any of [1] to [675], wherein the mold comprises an acrylic polymer. [677]The method according to any of [1] to [676], wherein the mold comprises PMMA.[678]The method according to any of [1] to [677], wherein the mold comprises polybutylene PBT.[679]The method according to any of [1] to [678], wherein the mold comprises POM.[680]The method according to any of [1] to [679], wherein the mold comprises PET.[681]The method according to any of [1] to [680], wherein the mold comprises PE.[682]The method according to any of [1] to [681], wherein the mold comprises a polymer comprising monomers linked by amide bonds.[683]The method according to any of [1] to [682], wherein the mold comprises PA.[684]The method according to any of [1] to [683], wherein the mold comprises aliphatic polyamide.[685]The method according to any of [1] to [684], wherein the mold comprises nylon.[686]The method according to any of [1] to [685], wherein the mold comprises a PA11 family material,[687]The method according to any of [1] to [686], wherein the mold comprises a PA12 family material.[688]The method according to any of [1] to [687], wherein the mold comprises PA12.[689]The method according to any of [1] to [688], wherein the mold comprises PA6.[690]The method according to any of [1] to [689], wherein the mold comprises a PA6 family material.[691]The method according to any of [1] to [690] wherein the mold comprises a polyolefin,[692]The method according to any of [1] to [691] wherein the mold comprises a polyamide.[693]The method according to any of [1] to [692] wherein the mold comprises a polyolefin and/or a polyamide.[694]The method according to any of [1] to [693] wherein the polymers encompass their copolymers.[695]The method according to any of [1] to [694] wherein the mold comprises a semi-crystalline thermoplastic polymer.[696]The method according to any of [1] to [695] wherein the melting temperature of the semi-crystalline thermoplastic polymer is below 290° C.[697]The method according to any of [1] to [696] wherein the melting temperature of the semi-crystalline thermoplastic polymer is above 28° C.[698]The method according to any of [1] to [697] wherein the crystallinity of the polymer is above 12%.[699]The method according to any of [1] to [698] wherein the mold comprises a polymeric material wherein 16 vol % or more of the polymeric material is kept at a large enough molecular weight of 8500 or more and the 55 vol % or less of the polymeric material is kept at a low enough molecular weight of 4900000 or less.[700]The method according to any of [1] to [699], wherein the mold is made of an elastomer.[701]The method according to any of [1] to [700], wherein the mold is made of PPS.[702]The method according to any of [1] to [701], wherein mold is made of PEEK.[703]The method according to any of [1] to [702], wherein the mold is made of P1. [704]The method according to any of [1] to [703], wherein the mold is made of viton.[705]The method according to any of [1] to [704] wherein the mold is made of a thermosetting polymer.[706]The method according to any of [1] to [705] wherein the mold is made of a thermoplastic polymer.[707]The method according to any of [1] to [706], wherein the MAM technology used in the forming step comprises form the component layer by layer.[708]The method according to any of [1] to [707], wherein the MAM technology comprises the use of an organic material.[709]The method according to any of [1] to [708], wherein the MAM method used to form the component is selected from: fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS), selective heat sintering (SHS), direct energy deposition (DeD), big area additive manufacturing (BAAM) and/or combinations thereof.[710]The method according to any of [1] to [709], wherein the MAM method used to form the component is FDM.[711]The method according to any of [1] to [710], wherein the MAM method used to form the component is FFF.[712]The method according to any of [1] to [711], wherein the MAM method used to form the component is DLS.[713]The method according to any of [1] to [712], wherein the MAM method used to form the component is a technology based on CLIP.[714]The method according to any of [1] to [713], wherein the MAM method used to form the component is SLA.[715]The method according to any of [1] to [714], wherein the MAM method used to form the component is DLP.[716]The method according to any of [1] to [715], wherein the MAM method used to form the component is SHS.[717]The method according to any of [1] to [716], wherein the MAM method used to form the component is SLS.[718]The method according to any of [1] to [717], wherein the MAM method used to form the component is BJ.[719]The method according to any of [1] to [718], wherein the MAM method used to form the component is MJ.[720]The method according to any of [1] to [719], wherein the MAM method used to form the component is DOD.[721]The method according to any of [1] to [720], wherein the MAM method used to form the component is MJF.[722]The method according to any of [1] to [721], wherein the MAM method used to form the component is DeD.[723]The method according to any of [1] to [722], wherein the MAM method used to form the component is CDLP.[724]The method according to any of [1] to [723], wherein the MAM method used to form the component is BAAM.[725]The method according to any of any of [1] to [724], wherein at least two different MAM methods are used to form the component.[726]The method according to any of [1] to [725], wherein the AM technology used to manufacture the component in the forming step comprises form the component layer by layer.[727]The method according to any of [1] to [726], wherein the AM technology used to manufacture the mold comprises form the mold layer by layer.[728]The method according to any of [1] to [727], wherein the AM technology used to form the component is selected from: fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), selective laser sintering (SLS), selective heat sintering (SHS), direct energy deposition (DeD), big area additive manufacturing (BAAM), direct metal laser melting (DMLS), selective laser melting (SLM), electron beam melting (EBM), Joule printing, and/or combinations thereof.[729]The method according to any of [1] to [728], wherein the AM technology used to form the component is selected from: selective laser sintering (SLS), selective laser melting (SLM), electron beam melting (EBM), direct energy deposition (DeD) big area additive manufacturing (BAAM) and/or combinations thereof.[730]The method according to any of [1] to [729], wherein the AM technology comprises the use of an organic material.[731]The method according to any of [1] to [730], wherein the AM technology used to form the component is selected from: fused deposition (FDM), fused filament fabrication (FFF), stereolithography (SLA), digital light processing (DLP), continuous digital light processing (CDLP), digital light synthesis (DLS), a technology based on continuous liquid interface production (CLIP), material jetting (MJ), drop on demand (DOD), multi jet fusion (MJF), binder jetting (BJ), laser sintering (SLS), selective heat sintering (SHS), direct energy deposition (DeD), big area additive manufacturing (BAAM) and/or combinations thereof.[732]The method according to any of [1] to [731], wherein the AM method used to form the component is FDM.[733]The method according to any of [1] to [732], wherein the AM method used to form the component is FFF.[734]The method according to any of [1] to [733], wherein the AM method used to form the component is DLS.[735]The method according to any of [1] to [734], wherein the AM method used to form the component is a technology based on CLIP.[736]The method according to any of [1] to [735], wherein the AM method used to form the component is SLA.[737]The method according to any of [1] to [736], wherein the AM method used to form the component is DLP.[738]The method according to any of [1] to [737], wherein the AM method used to form the component is SHS.[739]The method according to any of [1] to [738], wherein the AM method used to form the component is SLS.[740]The method according to any of [1] to [739], wherein the AM method used to form the component is BJ.[741]The method according to any of [1] to [740], wherein the AM method used to form the component is MJ.[742]The method according to any of [1] to [741], wherein the AM method used to form the component is DOD.[743]The method according to any of [1] to [742], wherein the AM method used to form the component is MJF.[744]The method according to any of [1] to [743], wherein the AM method used to form the component is DeD.[745]The method according to any of [1] to [744], wherein the AM method used to form the component is CDLP.[746]The method according to any of [1] to [745], wherein the AM method used to form the component is BAAM.[747]The method according to any of [1] to [746], wherein the AM method used to form the component is DMLS.[748]The method according to any of [1] to [747], wherein the AM method used to form the component is SLM.[749]The method according to any of [1] to [748], wherein the AM method used to form the component is EBM.[750]The method according to any of [1] to [749], wherein the AM method used to form the component is Joule printing.[751]The method according to any of any of [1] to [750], wherein at least two different AM methods are used to form the component.[752]The method according to any of any of [1] to [751], wherein the AM method used to manufacture the component comprises the use of a filament comprising a mixture of an organic material and the powder or powder mixture.[753]The method according to any of any of [1] to [752], wherein the AM method used to manufacture the component comprises fuse at least part of the organic material in the filament.[754]The method according to any of [1] to [753], wherein the AM method used in the forming step is SLS.[755]The method according to any of [1] to [754], wherein the AM method used in the forming step is MJF.[756]The method according to any of any of [1] to [755], wherein the AM method used in the forming step is DOD.[757]The method according to any of [1] to [756], wherein the AM method used in the forming step is SLA.[758]The method according to any of [1] to [757], wherein the AM method used in the forming step is BJ.[759]The method according to any of [1] to [758], wherein the AM method used in the forming step is DLP.[760]The method according to any of [1] to [759], wherein the AM method used in the forming step is CDLP.[761]The method according to any of [1] to [760], wherein the AM method used in the forming step is FDM.[762]The method according to any of [1] to [761], wherein the AM method used in the forming step is FFF.[763]The method according to any of [1] to [762], wherein the AM method used in the forming step is Joule printing.[764]The method according to any of [1] to [763], wherein the AM method used in the forming step is SHS.[765]The method according to any of [1] to [764], wherein the AM method used in the forming step is BAAM.[766]The method according to any of [1] to [765], wherein the AM method used in the forming step is SLM.[767]The method according to any of [1] to [766], wherein the AM method used in the forming step is EBM.[768]The method according to any of [1] to [767], wherein the AM method used in the forming step is DoD.[769]The method according to any of [1] to [768], wherein the AM method used to manufacture the component in the forming step is a BAAM method, where deposition is achieved through a system resembling a FDM, and where the filament is a mixture of an organic material and a metallic powder or a metal comprising powder mixture.[770]The method according to any of [1] to [769], wherein the AM method used to manufacture the component in the forming step is a BAAM method, where the component build process is made by means of adhesive bonding of the organic material.[771]The method according to any of [1] to [770], wherein the AM method used to manufacture the component in the forming step is a BAAM method, where the component build process does not involve fusion of metallic particles.[772]The method according to any of [1] to [771], wherein the AM method used to manufacture the component in the forming step is a BAAM method, where deposition is achieved through at least a printer head that projects a powder or powder mixture and an organic material.[773]The method according to any of [1] to [772], wherein the AM method used to manufacture the component in the forming step is a BAAM method, where deposition is achieved through at least one printer head that projects the powder or powder mixture and the organic material separately.[774]The method according to any of [1] to [773], wherein the AM method used to manufacture the component in the forming step is a BAAM method, where deposition is achieved through a system resembling a cold spray system.[775]The method according to any of [1] to [774], wherein the AM method used to manufacture the component in the forming step is a BAAM method, where deposition is achieved by high velocity projection of a powder or powder mixture.[776]The method according to any of [1] to [775], wherein the AM method used to manufacture the component in the forming step is a BAAM method, where deposition is achieved by high velocity projection of a mixture of organic particles and metallic and/or ceramic particles.[777]The method according to any of [1] to [776], wherein the AM method used to manufacture the component in the forming step is a BAAM method, where at least part of the metallic particles are fused during the component build process.[778]The method according to any of [1] to [777], wherein the AM method used to manufacture the component in the forming stop is a BAAM method, where all the metallic particles are fused during the component build process.[779]The method according to any of [1] to [778], wherein the apparent density of the metallic part of the component after the forming step is higher than 21% and less than 99.98%.[780]The method according to any of [1] to [779], wherein the apparent density of the metallic part of the component after the forming step is higher than 31% and less than 99.98%.[781]The method according to any of [1] to [780], wherein the apparent density of the metallic part of the component after the forming step is less than 99.8%.[782]The method according to any of [1] to [781], wherein the apparent density of the metallic part of the component after the forming step is higher than 31% and less than 99.8%.[783]The method according to any of [1] to [782], wherein the apparent density of the metallic part of the component after the forming step is higher than 51% and less than 99.8%.[784]The method according to any of [1] to [783], wherein the apparent density of the metallic part of the component after the forming step is higher than 71% and less than 99.98%/o.[785]The method according to any of [1] to [784], wherein the apparent density of the metallic part of the component after the forming step is less than 98.4%.[786]The method according to any of [1] to [785], wherein the apparent density of the metallic part of the component after the forming step is less than 89.8%.[787]The method according to any of [1] to [786], wherein the apparent density of the metallic part of the component after the forming step is higher than 31%.[788]The method according to any of [1] to [787], wherein the apparent density of the metallic part of the component after the forming step is higher than 41%.[789]The method according to any of [1] to [788], wherein the apparent density of the metallic part of the component after the forming step is higher than 51%.[790]The method according to any of [1] to [789], wherein the apparent density of the metallic part of the component after the forming step is higher than 86%.[791]The method according to any of [1] to [790], wherein the % NMVS in the metallic part of the component after the forming step is above 0.02% and below 99.98%.[792]The method according to any of [1] to [791], wherein the % NMVS in the metallic part of the component after the forming step is above 6% and below 99.98%.[793]The method according to any of [1] to [792], wherein the % NMVS in the metallic part of the component after the forming step is above 0.02% and below 99.8%.[794]The method according to any of [1] to [793], wherein the % NMVS in the metallic part of the component after the forming step is above 0.2%.[795]The method according to any of [1] to [794], wherein the % NMVS in the metallic part of the component after the forming step is above 6%.[796]The method according to any of [1] to [795], wherein the % NMVS in the metallic part of the component after the forming step is above 12% and below 98%.[797]The method according to any of [1] to [796], wherein the % NMVS in the metallic part of the component after the forming step is above 31%.[798]The method according to any of [1] to [797], wherein the % NMVS in the metallic part of the component after the forming step is above 51%.[799]The method according to any of [1] to [798], wherein the % NMVS in the metallic part of the component after the forming step is above 1.1%.[800]The method according to any of [1] to [799], wherein the % NMVC in the metallic part of the component after the forming step is above 0.3% and below 64%.[801]The method according to any of [1] to [800], wherein the % NMVC in the metallic part of the component after the forming step is above 1.2%.[802]The method according to any of [1] to [801], wherein the % NMVC in the metallic part of the component after the forming step is above 1.2% and below 49%.[803]The method according to any of [1] to [802], wherein the % NMVC in the metallic part of the component after the forming step is above 3.2%.[804]The method according to any of [1] to [803], wherein the % NMVC in the metallic part of the component after the forming step is below 49%.[805]The method according to any of [1] to [804], wherein the % NMVC in the metallic part of the component after the forming step is below 24%.[806]The method according to any of [1] to [805], wherein the pressure and/or temperature treatment comprises applying a pressure between 6 MPa and 2100 MPa.[807]The method according to any of [1] to [806], wherein the pressure and/or temperature treatment comprises applying a pressure of 60 MPa or more.[808]The method according to any of [1] to [807], wherein the pressure and/or temperature treatment comprises applying a pressure of 110 MPa or more.[809]The method according to any of [1] to [808], wherein the pressure and/or temperature treatment comprises applying a pressure of 1600 MPa or less.[810]The method according to any of [1] to [809], wherein the pressure and/or temperature treatment comprises applying a pressure of 1200 MPa or less.[811]The method according to any of [1] to [810], wherein the pressure is the mean pressure applied.[812]The method according to any of [1] to [811], wherein the pressure is the maximum pressure applied.[813]The method according to any of [1] to [812], wherein any pressure maintained less than 3 seconds is not considered.[814]The method according to any of [1] to [813], wherein any pressure maintained less than 9 seconds is not considered.[815]The method according to any of [1] to [814], wherein the pressure and/or temperature treatment comprises applying a temperature above 0.16*Tm and below 0.94*Tm.[816]The method according to any of [1] to [815], wherein the pressure and/or temperature treatment comprises applying a temperature above 0.19*Tm.[817]The method according to any of [1] to [816], wherein the pressure and/or temperature treatment comprises applying a temperature above 0.26*Tm. [818]The method according to any of [1] to [817], wherein the pressure and/or temperature treatment comprises applying a temperature below 0.84*Tm.[819]The method according to any of [1] to [818], wherein the pressure and/or temperature treatment comprises applying a temperature below 0.74*Tm. [820]The method according to any of [1] to [819], wherein the pressure and/or temperature treatment comprises applying a temperature above −14° C. and below 649° C.[821]The method according to any of [1] to [820], wherein the pressure and/or temperature treatment comprises applying a temperature above 9° C.[822]The method according to any of [1] to [821], wherein the pressure and/or temperature treatment comprises applying a temperature above 31° C.[823]The method according to any of [1] to [822], wherein the pressure and/or temperature treatment comprises applying a temperature below 440° C.[824]The method according to any of [1] to [823], wherein the pressure and/or temperature treatment comprises applying a temperature below 298° C.[825]The method according to any of [1] to [824], wherein the temperature is the mean temperature applied.[826]The method according to any of [1] to [825], wherein the temperature is the maximum temperature applied.[827]The method according to any of [1] to [826], wherein any temperature maintained less than 3 seconds is not considered.[828]The method according to any of [1] to [827], wherein any temperature maintained less than 9 seconds is not considered.[829]The method according to any of [1] to [828], wherein the maximum temperature gradient of the pressurized fluid during the pressure and/or temperature treatment is more than 6° C. and less than 380° C.[830]The method according to any of [1] to [829], wherein the maximum temperature gradient of the pressurized fluid during the pressure and/or temperature treatment is more than 11° C.[831]The method according to any of [1] to [830], wherein the maximum temperature gradient of the pressurized fluid during the pressure and/or temperature treatment is more than 16° C.[832]The method according to any of [1] to [831], wherein the maximum temperature gradient of the pressurized fluid during the pressure and/or temperature treatment is less than 290° C.[833]The method according to any of [1] to [832], wherein the maximum temperature gradient of the pressurized fluid during the pressure and/or temperature treatment is less than 245° C.[834]The method according to any of [1] to [833], wherein the maximum temperature gradient is maintained for at least 1 s.[835]The method according to any of [1] to [834], wherein the maximum temperature gradient is maintained for at least 21 s.[836]The method according to any of [1] to [835], wherein the maximum temperature gradient is maintained less than 119 hours.[837]The method according to any of [1] to [836], wherein the pressure and/or temperature treatment comprises the following steps: step i) subjecting the mold to high pressure: step ii) while keeping a high pressure level, raising the temperature of the mold; step iii) while keeping a high enough temperature, releasing at least some of the to the mold applied pressure.[838]The method according to any of any of [1] to [837], wherein the pressure and/or temperature treatment comprises the following steps: step i) subjecting the component to high pressure; step ii) while keeping a high pressure level, raising the temperature of the component; step iii) while keeping a high enough temperature, releasing at least some of the to the component applied pressure.[839]The method according to any of [1] to [838], wherein high pressure means a right amount of maximum pressure.[840]The method according to any of [1] to [839], wherein the right amount of maximum pressure in step i) is between 12 MPa and 1900 MPa.[841]The method according to any of [1] to [840], wherein the right amount of maximum pressure in step i) is more than 105 MPa.[842]The method according to any of [1] to [841], wherein the right amount of maximum pressure in step i) is more than 410 MPa.[843]The method according to any of [1] to [842], wherein the right amount of maximum pressure in step i) is more than 510 MPa.[844]The method according to any of [1] to [843], wherein the right amount of maximum pressure in step i) is less than 900 MPa.[845]The method according to any of [1] to [844], wherein the right amount of maximum pressure in step i) is less than 690 MPa.[846]The method according to any of [1] to [845], wherein the right amount of maximum pressure means the maximum pressure.[847]The method according to any of [1] to [846], wherein the right amount of maximum pressure in step i) is applied in a stepwise manner, wherein the first step is done within the first 20% of the right amount of maximum pressure.[848]The method according to any of [1] to [847], wherein the first step holding time is at least 2 seconds.[849]The method according to any of [1] to [848], wherein the variation on the applied pressure is ±5% or less.[850]The method according to any of [1] to [849], wherein there are at least two steps.[851]The method according to any of [1] to [850], wherein the pressure is applied at a rate of 980 MPa/s or less at least within the initial stretch.[852]The method according to any of [1] to [851], wherein the pressure is applied at a rate higher than 0.9 MPa/h at least within the initial stretch.[853]The method according to any of [1] to [852], wherein the initial stretch is the first 5% of the right amount of maximum pressure.[854]The method according to any of [1] to [853], wherein the mold is introduced in the pressure application device, when the fluid used to apply the pressure is hot.[855]The method according to any of [1] to [854], wherein the component is introduced in the pressure application device, when the fluid used to apply the pressure is hot.[856]The method according to any of [1] to [855], wherein hot means with a temperature of 35° C. or more.[857]The method according to any of [1] to [856], wherein hot means with a temperature of 145° C. or less.[858]The method according to any of [1] to [857], wherein the temperature is raised to 320 K or more in step ii).[859]The method according to any of [1] to [858], wherein the temperature is raised to 380 K or more in step ii).[860]The method according to any of [1] to [859], wherein the temperature is kept below 690K in step ii).[861]The method according to any of [1] to [860], wherein the temperature is kept below 660K in step ii).[862]The method according to any of [1] to [861], wherein the temperature is kept below 0.73*Tm.[863]The method according to any of [1] to [862], wherein the maximum relevant temperature achieved in step ii) is 190° C. or less. [864]The method according to any of [1] to [863], wherein the maximum relevant temperature achieved in step ii) is 190° C. or less 140° C. or less.[865]The method according to any of [1] to [864], wherein a relevant temperature refers to a temperature which is maintained more than 1 second.[866]The method according to any of [1] to [865], wherein a relevant temperature refers to a temperature which is maintained more than 20 seconds.[867]The method according to any of [1] to [866], wherein while keeping a high pressure level means a right pressure level in step ii).[868]The method according to any of [1] to [867], wherein a right pressure level in step ii) is between 0.5 MPa and 1300 MPa.[869]The method according to any of [1] to [868], wherein a right pressure level in step ii) is 5.5 MPa or more.[870]The method according to any of [1] to [869], wherein a right pressure level in step ii) is 1300 MPa or less.[871]The method according to any of [1] to [870], wherein a high enough temperature in step iii) means between 320K and 690 K.[872]The method according to any of [1] to [871], wherein a high enough temperature in step iii) means below 560K.[873]The method according to any of [1] to [872], wherein a high enough temperature in step iii) means 350 K or more.[874]The method according to any of [1] to [873], wherein after step iii) the pressure applied to the mold is completely released.[875]The method according to any of [1] to [874], wherein after step iii) the temperature of the mold is let drop to below 38° C.[876]The method according to any of [1] to [875], wherein after step iii) the pressure applied to the component is completely released.[877]The method according to any of [1] to [876], wherein after step iii) the temperature of the component is let drop to below 38° C.[878]The method according to any of [1] to [877], wherein the pressure and/or temperature treatment comprises the application of pressure in a homogeneous way.[879]A method for manufacturing a component wherein the method comprises the application of pressure in a homogeneous way.[880]The method according to any of [1] to [879], wherein the application of pressure in a homogeneous way comprises using a fluid with the right level of viscosity.[881]The method according to any of [1] to [880], wherein the application of pressure in a homogeneous way comprises applying the pressure using a fluid the proper temperature resistance.[882]The method according to any of [1] to [881], wherein the application of pressure in a homogeneous way comprises using a fluid with the right level of viscosity.[883]The method according to any of [1] to [882], wherein the application of pressure in a homogeneous way comprises using a fluid with the right level of polarity.[884]The method according to any of [1] to [883], wherein the application of pressure in a homogeneous way comprises the use of a hydrophobic fluid.[885]The method according to any of [1] to [884], wherein the fluid with the right level of viscosity comprises a silicon-based material.[886]The method according to any of [1] to [885], wherein the fluid with the right level of viscosity comprises a silicon fluid.[887]The method according to any of [1] to [886], wherein the fluid with the right level of viscosity comprises a fluid with at least one siloxane functional group.[888]The method according to any of [1] to [887], wherein the fluid with the right level of viscosity comprises a polydimethylsiloxane.[889]The method according to any of [1] to [888], wherein the fluid with the right level of viscosity comprises a linear polydimethylsiloxane fluid.[890]The method according to any of [1] to [889], wherein the fluid with the right level of viscosity comprises a silicon oil.[891]The method according to any of [1] to [890], wherein the fluid with the right level of viscosity comprises a perfluorinated oil.[892]The method according to any of [1] to [891], wherein the fluid with the right level of viscosity comprises a perfluorinated polyether oil (PFPE).[893]The method according to any of [1] to [892], wherein the fluid with the right level of viscosity comprises a perfluorinated polyether solid lubricant.[894]The method according to any of [1] to [893], wherein the fluid with the right level of viscosity comprises a lithium base solid lubricant.[895]The method according to any of [1] to [894], wherein the fluid with the right level of viscosity comprises a fluid with at least one olefin functional group.[896]The method according to any of [1] to [895], wherein the fluid with the right level of viscosity comprises a fluid with at least one alphaolefin functional group.[897]The method according to any of [1] to [896], wherein the fluid with the right level of viscosity comprises a polyalphaolefin.[898]The method according to any of [1] to [897], wherein the fluid with the right level of viscosity comprises a metallocene polyalphaolefin.[899]The method according to any of [1] to [898], wherein the fluid with the right level of viscosity comprises an oil.[900]The method according to any of [1] to [899], wherein the fluid with the right level of viscosity comprises a mineral oil.[901]The method according to any of [1] to [900], wherein the fluid with the right level of viscosity comprises a vegetable oil.[902]The method according to any of [1] to [901], wherein the fluid with the right level of viscosity comprises a natural oil.[903]The method according to any of [1] to [902], wherein the fluid with the right level of viscosity comprises a grease.[904]The method according to any of [1] to [903], wherein the fluid with the right level of viscosity comprises an animal grease or fat.

[905]The method according to any of [1] to [904], wherein the fluid with the right level of viscosity comprises a grease which comprises a perfluorinated polyether oil (PFPE).[906]The method according to any of [1] to [905], wherein the fluid with the right level of viscosity comprises a grease which comprises a silicone oil.[907]The method according to any of [1] to [906], wherein the fluid with the right level of viscosity comprises a grease which comprises a perfluorinated polyether solid lubricant.[908]The method according to any of [1] to [907], wherein the fluid with the right level of viscosity comprises a grease which comprises a lithium base solid lubricant.[909]The method according to any of [1] to [908], wherein the fluid with the right level of viscosity comprises a grease with a NLGI index greater than 000.[910]The method according to any of [1] to [909], wherein the fluid with the right level of viscosity comprises a grease with a NLGI index greater than 00.[911]The method according to any of [1] to [910], wherein the fluid with the right level of viscosity comprises a grease with a NLGI index (acc. To DIN 51818) greater than 0.[912]The method according to any of [1] to [911], wherein the fluid with the right level of viscosity comprises a grease with a NLGI index greater than 1.[913]The method according to any of [1] to [912], wherein the fluid with the right level of viscosity comprises a grease with a NLGI index greater than 2.[914]The method according to any of [1] to [913], wherein the fluid with the right level of viscosity comprises a grease with a NLGI index greater than 3.[915]The method according to any of [1] to [914], wherein the fluid with the right level of viscosity comprises a grease with a NLGI index greater or equal to 4.[916]The method according to any of [1] to [915], wherein the fluid with the right level of viscosity comprises a grease with a NLGI index smaller or equal to 00.[917]The method according to any of [1] to [916], wherein the fluid with the right level of viscosity comprises a grease with a NLGI index smaller or equal to 0.[918]The method according to any of [1] to [917], wherein the fluid with the right level of viscosity comprises a grease with a NLGI index smaller or equal to 1.[919]The method according to any of [1] to [918], wherein the fluid with the right level of viscosity comprises a grease with a NLGI index smaller or equal to 2.[920]The method according to any of [1] to [919], wherein the fluid with the right level of viscosity comprises a grease with a NLGI index smaller or equal to 3.[921]The method according to any of [1] to [920], wherein the fluid with the right level of viscosity comprises a grease with a NLGI index smaller than 4.[922]The method according to any of [1] to [921], wherein NLGI index is determined according to DIN 51818.[923]The method according to any of [1] to [922], wherein the fluid with the right level of viscosity has a viscosity of 1.1 cSt or more but below 490000000 cSt.[924]The method according to any of [1] to [923], wherein the fluid with the right level of viscosity has a viscosity of 1.6 cSt or more.[925]The method according to any of [1] to [924], wherein the fluid with the right level of viscosity has a viscosity of 6 cSt or more.[926]The method according to any of [1] to [925], wherein the fluid with the right level of viscosity has a viscosity of 1006 cSt or more.[927]The method according to any of [1] to [926], wherein the fluid with the right level of viscosity has a viscosity of 10016 cSt or more.[928]The method according to any of [1] to [927], wherein the fluid with the right level of viscosity has a viscosity of 1560000 cSt or more.[929]The method according to any of [1] to [928], wherein the fluid with the right level of viscosity has a viscosity of 11001000 cSt or more.[930]The method according to any of [1] to [929], wherein the fluid with the right level of viscosity has a viscosity below 94000000 cSt.[931]The method according to any of [1] to [930], wherein the fluid with the right level of viscosity has a viscosity below 49000000 cSt.[932]The method according to any of [1] to [931], wherein the fluid with the right level of viscosity has a viscosity below 940000 cSt.[933]The method according to any of [1] to [932], wherein the viscosity is measured at room temperature and 1 atm.[934]The method according to any of [1] to [933], wherein the viscosity is measured according to JISZ8803-2011.[935]The method according to any of [1] to [934], wherein the right level of polarity is a dielectric loss between 0.006 and 3.99.[936]The method according to any of [1] to [935], wherein the right level of polarity is a dielectric loss of 1.99 or less.[937]The method according to any of [1] to [936], wherein the right level of polarity is a dielectric loss of, of 0.011 or more.[938]The method according to any of [1] to [937], wherein the right level of polarity is a dielectric constant between 1.1 and 48.[939]The method according to any of [1] to [938], wherein the right level of polarity is a dielectric constant of 18 or less.[940]The method according to any of [1] to [939], wherein the right level of polarity means a dielectric constant of 1.6 or more.[941]The method according to any of [1] to [940], wherein the dielectric loss is measured 2.45 GHz. [942]The method according to any of [1] to [941], wherein the dielectric loss is measured at 915 MHz.[943]The method according to any of [1] to [942], wherein the dielectric constant is measured 2.45 GHz.[944]The method according to any of [1] to [943], wherein the dielectric constant is measured at 915 MHz.[945]The method according to any of [1] to [944], wherein the proper temperature resistance is between 56° C. and 588° C.[946]The method according to any of [1] to [945], wherein the proper temperature resistance is 92° C. or more.[947]The method according to any of [1] to [946], wherein the proper temperature resistance is 498° C. or less.[948]The method according to any of [1] to [947], wherein at least two different fluids are used to transmit the pressure.[949]The method according to any of [1] to [948], wherein at least two different fluids separated from each other are employed.[950]The method according to any of [1] to [949], wherein the fluid in direct contact with the component is separated with a pressure transmitting container from the other fluids. One could name the fluid in direct contact with the polymeric mold the inner fluid and the fluid (or fluids) transmitting pressure to the inner fluid could be named outer fluid. In an embodiment, [951]The method according to any of [1] to [950], wherein the fluid in direct contact with the mold has a higher kinematic viscosity than at least one of the outer fluids,[952]The method according to any of [1] to [951], wherein the fluid in direct contact with the component has a higher kinematic viscosity than at least one of the outer fluids.[953]The method according to any of [1] to [952], wherein a higher kinematic viscosity is a difference of at least 20 cSt and less than 89000000 cSt.[954]The method according to any of [1] to [953], wherein a higher kinematic viscosity is a difference of at least 206 cSt and less than 89000000 cSt.[955]The method according to any of [1] to [954], wherein a higher kinematic viscosity is a difference of at least 20 cSt and less than 19000000 cSt.[956]The method according to any of [1] to [955], wherein the fluid in direct contact with the component is separated with a pressure transmitting container from the other fluids.[957]The method according to any of [1] to [956], wherein the fluid in direct contact with the mold is separated with a pressure transmitting container from the other fluids.[958]The method according to any of [1] to [957], wherein the material of the pressure transmitting container comprises an elastomer.[959]The method according to any of [1] to [958], wherein the material of the pressure transmitting container comprises a polymer.[960]The method according to any of [1] to [959], wherein the material of the pressure transmitting container comprises at least one of: HNBR, ACM, AEM, FVMQ, VMQ, FKM, FEPM, FFKM, PTFE, PPS, PEEK, Pl, viton, EPDM and/or mixtures thereof.[961]The method according to any of [1] to [960], wherein the material of the pressure transmitting container comprises a laminated polymer.[962]The method according to any of [1] to [961], wherein the material of the pressure transmitting container comprises at least two laminated polymers.[963]The method according to any of [1] to [962], wherein the material of the pressure transmitting container comprises at wherein the fluid with the right level of viscosity has a viscosity of 1.1 cSt or more but below 490000000 cSt.[924]The method according to any of [1] to [923], wherein the fluid with the right level of viscosity has a viscosity of 1.6 cSt or more.[925]The method according to any of [1] to [924], wherein the fluid with the right level of viscosity has a viscosity of 6 cSt or more.[926]The method according to any of [1] to [925], wherein the fluid with the right level of viscosity has a viscosity of 1006 cSt or more.[927]The method according to any of [1] to [926], wherein the fluid with the right level of viscosity has a viscosity of 10016 cSt or more.[928]The method according to any of [1] to [927], wherein the fluid with the right level of viscosity has a viscosity of 1560000 cSt or more.[929]The method according to any of [1] to [928], wherein the fluid with the right level of viscosity has a viscosity of 11001000 cSt or more.[930]The method according to any of [1] to [929], wherein the fluid with the right level of viscosity has a viscosity below 94000000 cSt.[931]The method according to any of [1] to [930], wherein the fluid with the right level of viscosity has a viscosity below 49000000 cSt.[932]The method according to any of [1] to [931], wherein the fluid with the right level of viscosity has a viscosity below 940000 cSt.[933]The method according to any of [1] to [932], wherein the viscosity is measured at room temperature and 1 atm.[934]The method according to any of [1] to [933], wherein the viscosity is measured according to JISZ8803-2011.[935]The method according to any of [1] to [934], wherein the right level of polarity is a dielectric loss between 0.006 and 3.99.[936]The method according to any of [1] to [935], wherein the right level of polarity is a dielectric loss of 1.99 or less.[937]The method according to any of [1] to [936], wherein the right level of polarity is a dielectric loss of, of 0.011 or more.[938]The method according to any of [1] to [937], wherein the right level of polarity is a dielectric constant between 1.1 and 48.[939]The method according to any of [1] to [938], wherein the right level of polarity is a dielectric constant of 18 or less.[940]The method according to any of [1] to [939], wherein the right level of polarity means a dielectric constant of 1.6 or more.[941]The method according to any of [1] to [940], wherein the dielectric loss is measured 2.45 GHz. [942]The method according to any of [1] to [941], wherein the dielectric loss is measured at 915 MHz.[943]The method according to any of [1] to [942], wherein the dielectric constant is measured 2.45 GHz.[944]The method according to any of [1] to [943], wherein the dielectric constant is measured at 915 MHz.[945]The method according to any of [1] to [944], wherein the proper temperature resistance is between 56° C. and 588° C.[946]The method according to any of [1] to [945], wherein the proper temperature resistance is 92° C. or more.[947]The method according to any of [1] to [946], wherein the proper temperature resistance is 498° C. or less.[948]The method according to any of [1] to [947], wherein at least two different fluids are used to transmit the pressure.[949]The method according to any of [1] to [948], wherein at least two different fluids separated from each other are employed.[950]The method according to any of [1] to [949], wherein the fluid in direct contact with the component is separated with a pressure transmitting container from the other fluids. One could name the fluid in direct contact with the polymeric mold the inner fluid and the fluid (or fluids) transmitting pressure to the inner fluid could be named outer fluid. In an embodiment, [951]The method according to any of [1] to [950], wherein the fluid in direct contact with the mold has a higher kinematic viscosity than at least one of the outer fluids,[952]The method according to any of [1] to [951], wherein the fluid in direct contact with the component has a higher kinematic viscosity than at least one of the outer fluids.[953]The method according to any of [1] to [952], wherein a higher kinematic viscosity is a difference of at least 20 cSt and less than 89000000 cSt.[954]The method according to any of [1] to [953], wherein a higher kinematic viscosity is a difference of at least 206 cSt and less than 89000000 cSt.[955]The method according to any of [1] to [954], wherein a higher kinematic viscosity is a difference of at least 20 cSt and less than 19000000 cSt.[956]The method according to any of [1] to [955], wherein the fluid in direct contact with the component is separated with a pressure transmitting container from the other fluids.[957]The method according to any of [1] to [956], wherein the fluid in direct contact with the mold is separated with a pressure transmitting container from the other fluids.[958]The method according to any of [1] to [957], wherein the material of the pressure transmitting container comprises an elastomer.[959]The method according to any of [1] to [958], wherein the material of the pressure transmitting container comprises a polymer.[960]The method according to any of [1] to [959], wherein the material of the pressure transmitting container comprises at least one of: HNBR, ACM, AEM, FVMQ, VMQ, FKM, FEPM, FFKM, PTFE, PPS, PEEK, Pl, viton, EPDM and/or mixtures thereof.[961]The method according to any of [1] to [960], wherein the material of the pressure transmitting container comprises a laminated polymer.[962]The method according to any of [1] to [961], wherein the material of the pressure transmitting container comprises at least two laminated polymers.[963]The method according to any of [1] to [962], wherein the material of the pressure transmitting container comprises at least two laminated to each other polymers.[964]The method according to any of [1] to [963], wherein the material of the pressure transmitting container comprises a laminated polymer and a metal comprising foil.[965]The method according to any of [1] to [964], wherein the material of the pressure transmitting container comprises a laminated polymer and a metallic foil.[966]The method according to any of [1] to [965], wherein the material of the pressure transmitting container comprises a laminated polymer and a metallic foil joined trough lamination.[967]The method according to any of [1] to [966], wherein the material of the pressure transmitting container comprises a laminated polymer and a metal comprising adhesive band.[968]The method according to any of [1] to [967], wherein the pressure is applied through a fluidized bed comprising solid particles.[969]The method according to any of [1] to [968], wherein the pressure is applied through a fluidized bed comprising balls. [970]The method according to any of [1] to [969], wherein the pressure is applied through a fluidized bed comprising ceramic balls.[971]The method according to any of [1] to [970], wherein the pressure is applied through a fluidized bed comprising polymeric balls.[972]The method according to any of [1] to [971], wherein the pressure is applied through a fluidized bed comprising metal balls.[973]The method according to any of [1] to [972], wherein the pressure is applied through a fluidized bed comprising metal balls with the right level of elastic limit.[974]The method according to any of [1] to [973], wherein the right elastic limit is higher than 153 MPa and less than 4940 MPa.[975]The method according to any of [1] to [974], wherein the right elastic limit is higher than 210 MPa.[976]The method according to any of [1] to [975], wherein the right elastic limit is less than 3940 MPa.[977]The method according to any of [1] to [976], wherein the pressure is applied through a fluidized bed comprising metal balls with a low elastic limit.[978]The method according to any of [1] to [977], wherein, a low elastic limit is an elastic limit between 16 MPa and 190 MPa or less.[979]The method according to any of [1] to [978], wherein, a low elastic limit is 140 MPa or less.[980]The method according to any of [1] to [979], wherein a low elastic limit is 106 MPa or more.[981]The method according to any of [1] to [980], wherein the elastic limit is measured according to ASTM E8/E89M-16a at room temperature.[982]The method according to any of [1] to [981], wherein the size of the balls is between 0.0016 mm and 98 mm.[983]The method according to any of [1] to [982], wherein the size of the balls is 19 mm or less.[984]The method according to any of [1] to [983], wherein the size of the balls is 0.012 mm or more.[985]The method according to any of [1] to [984], wherein the balls size ratio, defined as the ratio between the diameter of large and small balls, is between 5.1 and 24.4.[986]The method according to any of [1] to [985], wherein the balls size ratio, defined as the ratio between the diameter of large and small balls, is 7.1 or more.[987]The method according to any of [1] to [986], wherein the balls size ratio, defined as the ratio between the diameter of large and small balls, is 19.4 or less.[988]The method according to any of [1] to [987], wherein the fluid applying the pressure comprises at least 3 vol % of balls.[989]The method according to any of [1] to [988], wherein the fluid applying the pressure comprises at least 6 vol % of balls.[990]The method according to any of [1] to [989], wherein the pressure is applied through a fluidized bed comprising a powder.[991]The method according to any of [1] to [990], wherein the pressure is applied through a fluidized bed comprising a ceramic powder.[992]The method according to any of [1] to [991], wherein the pressure is applied through a fluidized bed comprising a MgO powder.[993]The method according to any of [1] to [992], wherein the pressure is applied through a fluidized bed comprising a pyrophyllite powder.[994]The method according to any of [1] to [993], wherein the pressure is applied through a fluidized bed comprising a salt powder.[995]The method according to any of [1] to [994], wherein the pressure is at least partially applied through an at least partially molten polymer with a melting temperature above 26° C. and below 249° C.[996]The method according to any of [1] to [995], wherein the pressure is at least partially applied through an at least partially molten polymer with a melting temperature below 194° C.[997]The method according to any of [1] to [996], wherein the pressure is at least partially applied through an at least partially molten polymer with a melting temperature above 57° C.[998]The method according to any of [1] to [997], wherein the pressure is at least partially applied through an at least partially molten polymer with a melting temperature above 110° C. and below 249° C.[999]The method according to any of [1] to [998], wherein the pressure is at least partially applied through an at least partially molten polymer with a melting temperature below 194° C.[1000]The method according to any of [1] to [999], wherein the pressure is at least partially applied through an at least partially molten polymer with a melting temperature above 170° C.[1001]The method according to any of [1] to [1000], wherein the melting temperature of the polymer is measured according to ISO 11357-1/−32016.[1002]The method according to any of [1] to [1001], wherein the size of the polymeric material is between 26 microns and 143 microns.[1003]The method according to any of [1] to [1002], wherein the size of the polymeric material is 56 microns or more.[1004]The method according to any of [1] to [1003], wherein the size of the polymeric material is 93 microns or less.[1005]The method according to any of [1] to [1004], wherein the size refers to the D50 value.[1006]The method according to any of [1] to [1005], wherein D50 refers to the particle size at which 50/6 of the sample's volume is comprised of smaller particles in the cumulative distribution of particle size.[1007]The method according to any of [1] to [1006], wherein D50 refers to the particle size at which 50% of the sample's mass is comprised of smaller particles in the cumulative distribution of particle size.[1008]The method according to any of [1] to [1007], wherein the polymeric material comprises at least one of: PPS, PEEK, P1, PCL, porous PCL and/or mixtures thereof.[1009]The method according to any of [1] to [1008], wherein the polymeric material comprises polyphenylene sulfide (PPS).[1010]The method according to any of [1] to [1009], wherein the heating in the pressure and/or temperature treatment is at least partially made with microwaves.[1011]The method according to any of [1] to [1010], wherein the heating in the pressure and/or temperature treatment is made with microwaves.[1012]The method according to any of [1] to [1011], wherein the pressure and/or temperature treatment comprises heating with microwaves.[1013]A method for manufacturing a component wherein the method comprises heating with microwaves.[1014]The method according to any of [1] to [1013], wherein the microwave frequency is 2.45 GHz +/−250 MHz.[1015]The method according to any of [1] to [1014], wherein the microwave frequency is 5.8 GHz +/−1050 MHz.[1016]The method according to any of [1] to [1015], wherein the microwave frequency is 915 MHz +/−250 MHz.[1017]The method according to any of [1] to [1016], wherein the microwave frequency is 2.45 MHz +/−250 MHz.[1018]The method according to any of [1] to [1017], wherein the total power of the microwave generators employed is between 55 W and 55000 W.[1019]The method according to any of [1] to [1018], wherein the total power of the microwave generators employed is 155 W or more.[1020]The method according to any of [1] to [1019], wherein the total power of the microwave generators employed is 19000 W or less.[1021]The method according to any of [1] to [1020], wherein at least part of the powder filling the mold has the pertinent dielectric susceptibility.[1022]The method according to any of [1] to [1021], wherein the powder filling the mold has the pertinent dielectric susceptibility.[1023]The method according to any of [1] to [1022], wherein the mold has the pertinent dielectric susceptibility.[1024]The method according to any of [1] to [1023], wherein at least part of the powder mixture has the pertinent dielectric susceptibility.[1025]The method according to any of [1] to [1024], wherein the pertinent dielectric susceptibility is a dielectric loss of 2.09 or more.[1026]The method according to any of [1] to [1025], wherein the pertinent dielectric susceptibility is a dielectric loss of 199 or less.[1027]The method according to any of [1] to [1026], wherein the pertinent dielectric susceptibility is a dielectric constant of 2.4 or more.[1028]The method according to any of [1] to [1027], wherein the pertinent dielectric susceptibility is a dielectric constant of 24000 or less.[1029]The method according to any of [1] to [1028], wherein the dielectric constant is measured at 2.45 GHz.[1030]The method according to any of [1] to [1029], wherein the dielectric loss is measured at 2.45 GHz.[1031]The method according to any of [1] to [1030], wherein the dielectric constant is measured at 915 MHz.[1032]The method according to any of [1] to [1031], wherein the dielectric loss is measured at 915 MHz.[1033]The method according to any of [1] to [1032], wherein the heating with microwave is made in a high pressurized chamber.[1034]The method according to any of [1] to [1033], wherein a high pressurized chamber is a chamber pressurized with a fluid to 1200 bars or more.[1035]The method according to any of [1] to [1034], wherein a high pressurized chamber is a chamber pressurized with a fluid to 2100 bars or more.[1036]The method according to any of [1] to [1035], wherein the chamber is a furnace or pressure vessel.[1037]The method according to any of [1] to [1038], wherein the mold has the right level of polarity.[1038]The method according to any of [1] to [1037], wherein the mold is a polymeric mold.[1039]The method according to any of [1] to [1038], wherein the pressurizing fluid in the chamber comprises at least one fluid with the right level of polarity.[1040]The method according to any of [1] to [1039], wherein all fluids in the chamber present the right level of polarity.[1041]The method according to any of [1] to [1040], wherein the right level of polarity means a dielectric loss of 3.99 or less.[1042]The method according to any of [1] to [1041], wherein the right level of polarity means a dielectric loss of 0.006 or more.[1043]The method according to any of [1] to [1042], wherein the right level of polarity means a dielectric constant of 1000 or less.[1044]The method according to any of [1] to [1043], wherein the right level of polarity means a dielectric constant of 1.1 or more.[1045]The method according to any of [1] to [1044], wherein the high pressurized chamber comprises glowing elements.[1046]The method according to any of [1] to [1045], wherein the glowing materials are applied to an element comprised in the high pressurized chamber.[1047]The method according to any of [1] to [1046], wherein the glowing materials are applied in powder form.[1048]The method according to any of [1] to [1047], wherein the glowing materials are sprayed. [1049]The method according to any of [1] to [1048], wherein the glowing materials are sprayed in powder form.[1050]The method according to any of [1] to [1049], wherein at least part of the inner face of the element supporting the glowing materials is sprayed with the glowing materials.[1051]The method according to any of [1] to [1050], wherein the glowing materials comprise an alloy.[1052]The method according to any of [1] to [1051], wherein the glowing materials comprise a metallic alloy.[1053]The method according to any of [1] to [1052], wherein the glowing materials comprise a molybdenum alloy.[1054]The method according to any of [1] to [1053], wherein the glowing materials comprise a tungsten alloy.[1055]The method according to any of [1] to [1054], wherein the glowing materials comprise tungsten alloy.[1056]The method according to any of [1] to [1055], wherein the glowing materials comprise tantalum alloy.[1057]The method according to any of [1] to [1056], wherein the glowing materials comprise zirconium alloy.[1058]The method according to any of [1] to [1057], wherein the glowing materials comprise nickel alloy.[1059]The method according to any of [1] to [1058], wherein the glowing materials comprise an iron based alloy.[1060]The method according to any of [1] to [1059], wherein the glowing materials comprise a material with a high dielectric loss at the interesting frequency range.[1061]The method according to any of [1] to [1060], wherein the glowing materials comprise carbides.[1062]The method according to any of [1] to [1061], wherein the glowing materials comprise titanium carbides (TiC).[1063]The method according to any of [1] to [1062], wherein the glowing materials comprise borides.[1064]The method according to any of [1] to [1063], wherein the glowing materials comprise a barium titanate (BaTiO₃).[1065]The method according to any of [1] to [1064], wherein the glowing materials comprise a strontium titanate (SrTiO₃).[1066]The method according to any of [1] to [1065], wherein the glowing materials comprise a barium-strontium titanate (Ba, Sr (TiO₃)).[1067]The method according to any of [1] to [1066], wherein the step of applying a pressure and/or temperature treatment step is mandatory.[1068]The method according to any of [1] to [1067], wherein the step of applying a pressure and/or temperature treatment is optional.[1069]The method according to any of [1] to [1068], wherein the step of applying a pressure and/or temperature treatment is omitted.[1070]The method according to any of [1] to [1069], wherein the step of applying a pressure and/or temperature treatment before the debinding step is mandatory.[1071]The method according to any of [1] to [1070], wherein the step of applying a pressure and/or temperature treatment before the debinding step is omitted.[1072]The method according to any of [1] to [1071], wherein the step of applying a pressure and/or temperature treatment after the debinding step is omitted.[1073]The method according to any of [1] to [1072], wherein the step of applying a pressure and/or temperature treatment after the debinding step is mandatory.[1074]The method according to any of [1] to [1073], wherein step ii) is omitted.[1075]The method according to any of [1] to [1074], wherein step iii) is omitted.[1076]The method according to any of [1] to [1075], wherein the method further comprises applying a machining step to the component obtained after the forming step.[1077]The method according to any of [1] to [1076], wherein the debinding step comprises applying a thermal debinding.[1078]The method according to any of [1] to [1077], wherein the debinding step comprises applying a non-thermal debinding.[1079]The method according to any of [1] to [1078], wherein the debinding step comprises applying a chemical debinding.[1080]The method according to any of [1] to [1079], wherein the temperature in the debinding step is between 51° C. and 1390° C.[1081]The method according to any of [1] to [1080], wherein the temperature in the debinding step is 110° C. or more.[1082]The method according to any of [1] to [1081], wherein the temperature in the debinding step is 890° C. or less.[1083] The method according to any of [1] to [1082], wherein the atmosphere used in the debinding step comprises an organic gas.[1084]The method according to any of [1] to [1083], wherein the atmosphere used in the debinding step comprises % Ar.[1085]The method according to any of [1] to [1084], wherein the atmosphere used in the debinding step comprises % N₂.[1086]The method according to any of [1] to [1085], wherein the atmosphere used in the debinding step comprises % H₂.[1087]The method according to any of [1] to [1086], wherein the atmosphere used in the debinding step comprises 55 wt % or more % H₂.[1088]The method according to any of [1] to [1087], wherein the atmosphere used in the debinding step comprises % N₂, % H₂ and/or % Ar.[1089]The method according to any of [1] to [1088], wherein the debinding step comprises the application of a vacuum with an absolute pressure of 590 mbar or lower.[1090]The method according to any of [1] to [1089], wherein the debinding step comprises the application of a vacuum with an absolute pressure of 1.2*10⁻⁶ mbar or higher.[1091]The method according to any of [1] to [1090], wherein the debinding step comprises the application of a vacuum with an absolute pressure between 99 mbar and 1.2*10⁻⁴ mbar.[1092]The method according to any of [1] to [1091], wherein the atmosphere used in the debinding step comprises the application of a vacuum with an absolute pressure between 0.9*10⁻³ mbar and 0.9*10⁻⁹ mbar.[1093]The method according to any of [1] to [1092], wherein the atmosphere refers to the atmosphere of the furnace or pressure vessel where the debinding step is performed.[1094]The method according to any of [1] to [1093], wherein the method further comprises applying a machining step to the component obtained after the debinding step.[1095]The method according to any of [1] to [1094], wherein the debinding step is mandatory.[1096]The method according to any of [1] to [1095], wherein the debinding step is optional.[1097]The method according to any of [1] to [1096], wherein the debinding step is omitted.[1098]The method according to any of [1] to [1097], wherein, in the fixing step, the oxygen level of the metallic part of the component is set to more than 0.02 ppm and less than 390 ppm.[1099]The method according to any of [1] to [1098], wherein, in the fixing step, the oxygen level of the metallic part of the component is set to less than 140 ppm.[1100]The method according to any of [1] to [1099], wherein, in the the fixing step, the oxygen level of the metallic part of the component is set to more than 0.2 ppm.[1101]The method according to any of [1] to [1100], wherein, in the fixing step, the nitrogen level of the metallic part of the component is set to more than 0.01 ppm and less than 99 ppm.[1102]The method according to any of [1] to [1101], wherein, in the fixing step, the nitrogen level of the metallic part of the component is set to less than 99 ppm.[1103] The method according to any of [1] to [1102], wherein, in the fixing step, the nitrogen level of the metallic part of the component is set to less than 49 ppm.[1104]The method according to any of [1] to [1103], wherein, in the fixing step, the nitrogen level of the metallic part of the component is set to more than 0.06 ppm.[1105]The method according to any of [1] to [1104], wherein, in the fixing step, the nitrogen level of the metallic part of the component is set to more than 0.06 ppm and less than 19 ppm.[1106]The method according to any of [1] to [1105], wherein, in the fixing step, the oxygen level of the metallic part of the component is set to less than 390 ppm and the nitrogen level of the metallic part of the component to less than 99 ppm.[1107]The method according to any of [1] to [1106], wherein, in the fixing step, the oxygen level of the metallic part of the component is set to more than 0.02 ppm and less than 390 ppm and/or the nitrogen level of the metallic part of the component is set to more than 0.01 ppm and less than 99 ppm.[1108]The method according to any of [1] to [1107], wherein, in the fixing step, the oxygen level of the component is set to more than 0.2 ppm and less than 90 ppm and the nitrogen level of the metallic part of the component is set to more than 0.06 ppm and less than 49 ppm.[1109]The method according to any of [1] to [1108], wherein the fixing step comprises setting the oxygen level of the metallic part of the component between 260 ppm and 19000 ppm.[1110] The method according to any of [1] to [1109], wherein, in the fixing step, the oxygen level of the metallic part of the component is set to 520 ppm or more.[1111]The method according to any of [1] to [1110], wherein, in the fixing step, the oxygen level of the metallic part of the component is set to 1100 ppm or more.[1112] The method according to any of [1] to [1111], wherein, in the fixing step, the oxygen level of the metallic part of the component is set to 14000 ppm or less.[1113]The method according to any of [1] to [1112], wherein, in the fixing step, the oxygen level of the metallic part of the component is set to 9000 ppm or less.[1114]The method according to any of [1] to [1113], wherein, in the fixing step, the nitrogen level of the metallic part of the component is set between 0.02 wt % and 3.9 wt %.[1115]The method according to any of [1] to [1114], wherein, in the fixing step, the nitrogen level of the metallic part of the component is set to 0.2 wt % or more.[1116]The method according to any of [1] to [1115], wherein, in the fixing step the nitrogen level of the metallic part of the component is set to 0.3 wt % or more.[1117]The method according to any of [1] to [1116], wherein, in the fixing step, the nitrogen level of the metallic part of the component is set to 2.9 wt % or less.[1118]The method according to any of [1] to [1117], wherein, in the fixing step, the nitrogen level of the metallic part of the component is set to 1.9 wt % or less.[1119] The method according to any of [1] to [1118], wherein, in the fixing step, the oxygen level of the metallic part of the component is set to more than 260 ppm and less than 19000 ppm and/or the nitrogen level of the metallic part of the component is set between 0.02 wt % and 3.9 wt %.[1120]The method according to any of [1] to [1119], wherein the atmosphere used in the fixing step comprises % H₂ and/or % Ar.[1121]The method according to any of [1] to [1120], wherein the atmosphere used in the fixing step comprises % H₂.[1122]The method according to any of [1] to [1121], wherein the atmosphere used in the fixing step comprises % N₂.[1123]The method according to any of [1] to [1122], wherein the atmosphere used in the fixing step comprises % N₂ and/or % H₂.[1124]The method according to any of [1] to [1123], wherein the atmosphere used in the fixing step comprises 55 wt % or more % Ar.[1125]The method according to any of [1] to [1124], wherein the atmosphere used in the fixing step comprises a pH₂/pH₂O which is between 2*10⁻⁸ and 2*10¹³ being pH₂ the partial pressure of H₂ in bar and pH₂O the partial pressure of H₂O in bar.[1126] The method according to any of [1] to [1125], wherein the atmosphere used in the fixing step is changed from an atmosphere comprising 55 wt % or more % H₂ to an atmosphere comprising 55% or more % Ar.[1127]The method according to any of [1] to [1126], wherein the fixing step comprises the application of a vacuum with an absolute pressure of 590 mbar or lower.[1128]The method according to any of [1] to [1127], wherein the fixing step comprises the application of a vacuum with an absolute pressure of 99 mbar or lower.[1129]The method according to any of [1] to [1128], wherein the fixing step comprises the application of a vacuum with an absolute pressure of 9 mbar or lower.[1130]The method according to any of [1] to [1129], wherein the fixing step comprises the application of a vacuum with an absolute pressure of 0.9 mbar or lower.[1131]The method according to any of [1] to [1130], wherein the fixing step comprises the application of a vacuum with an absolute pressure of 0.9*10⁻² mbar or lower.[1132]The method according to any of [1] to [1131], wherein the fixing step comprises the application of a vacuum with an absolute pressure of 0.9*10⁻³ mbar or lower.[1133]The method according to any of [1] to [1132], wherein the fixing step comprises the application of a vacuum with an absolute pressure of 0.9*10⁻⁴ mbar or lower.[1134]The method according to any of [1] to [1133], wherein the fixing step comprises the application of a vacuum with an absolute pressure of 0.9*10-5 mbar or lower.[1135]The method according to any of [1] to [1134], wherein the fixing stop comprises the application of a vacuum with an absolute pressure of 0.9*10³ mbar or lower.[1136]The method according to any of [1] to [1135], wherein the fixing step comprises the application of a vacuum with an absolute pressure of 0.9*10⁻⁷ mbar or lower.[1137]The method according to any of [1] to [1136], wherein the fixing step comprises the application of a vacuum with an absolute pressure of 0.9*10⁻¹² mbar or higher.[1138]The method according to any of [1] to [1137], wherein the fixing step comprises the application of a vacuum with an absolute pressure of 0.9*10⁻¹¹ mbar or higher.[1139]The method according to any of [1] to [1138], wherein the fixing step comprises the application of a vacuum with an absolute pressure of 1.2*10⁻¹⁰ mbar or higher.[1140]The method according to any of [1] to [1139], wherein the fixing step comprises the application of a vacuum with an absolute pressure of 0.9*10⁻¹⁰ mbar or higher.[1141]The method according to any of [1] to [1140], wherein the fixing step comprises the application of a vacuum with an absolute pressure of 0.9*10⁻⁹ mbar or higher.[1142]The method according to any of [1] to [1141], wherein the fixing step comprises the application of a vacuum with an absolute pressure of 1.2*10⁻⁸ mbar or higher.[1143] The method according to any of [1] to [1142], wherein the fixing step comprises the application of a vacuum with an absolute pressure of 0.9*10⁻⁸ mbar or higher.[1144]The method according to any of [1] to [1143], wherein the fixing step comprises the application of a vacuum with an absolute pressure of 1.2*10⁻⁶ mbar or higher.[1145]The method according to any of [1] to [1144], wherein the fixing step comprises the application of a vacuum with an absolute pressure of 1.2*10⁻⁴ mbar or higher.[1146]The method according to any of [1] to [1145], wherein the fixing step comprises the application of a vacuum with an absolute pressure between 590 mbar and 1.2*10⁻⁸ mbar.[1147]The method according to any of [1] to [1146], wherein the fixing step comprises the application of a vacuum with an absolute pressure between 99 mbar and 1.2*10⁻⁶ mbar.[1148]The method according to any of [1] to [1147], wherein the fixing step comprises the application of a vacuum with an absolute pressure between 0.9 mbar and 1.2*10⁻⁴ mbar.[1149]The method according to any of [1] to [1148], wherein the fixing step comprises the application of a vacuum with an absolute pressure between 0.9*10⁻³ mbar and 0.9*10⁻¹² mbar.[1150]The method according to any of [1] to [1149], wherein the fixing step comprises the application of a vacuum with an absolute pressure between 0.9*10⁻³ mbar and 0.9*10⁻⁸ mbar.[1151]The method according to any of [1] to [1150], wherein the fixing step comprises the application of a vacuum with an absolute pressure which is changed from 0.9*10⁻² mbar or higher to 0.9*10⁻³ mbar or lower.[1152]The method according to any of [1] to [1151], wherein the fixing step comprises the use of an atmosphere with a carbon potential of the furnace or pressure vessel atmosphere in relation to the carbon potential of the surface of the component which is above 0.0001%.[1153] The method according to any of [1] to [1152], wherein the fixing step comprises the use of an atmosphere with a carbon potential of the furnace or pressure vessel atmosphere in relation to the carbon potential of the surface of the component which is above 0.01% and below 14%.[1154]The method according to any of [1] to [1153], wherein the carbon potential of the furnace or pressure vessel atmosphere in relation to the carbon content in the metallic part of the component after the fixing step is above 0.0001%.[1155]The method according to any of [1] to [1154], wherein the carbon potential of the furnace or pressure vessel atmosphere in relation to the carbon content in the metallic part of the component after the fixing step is below 69%.[1156]The method according to any of [1] to [1155], wherein the carbon potential of the furnace or pressure vessel atmosphere in relation to the carbon content in the metallic part of the component after the fixing step is defined as the absolute value of [(carbon content in the metallic part of the component after the fixing step —carbon potential of the furnace or pressure vessel atmosphere)/carbon potential of the furnace or pressure vessel atmosphere]*100.[1157]The method according to any of [1] to [1156], wherein the fixing step comprises the use of an atmosphere with an atomic nitrogen content of 0.078 mol % or more.[1158]The method according to any of [1] to [1157], wherein the fixing step comprises the use of an atmosphere with an atomic nitrogen content of 2.14 mol % or more.[1159]The method according to any of [1] to [1158], wherein the fixing step comprises the use of an atmosphere with an atomic nitrogen content of 89 mol % or less.[1160]The method according to any of [1] to [1159], wherein the fixing step comprises the use of an atmosphere with an atomic nitrogen content of 46.8 mol % or less.[1161]The method according to any of [1] to [1160], wherein the fixing step comprises the use of an atmosphere with an atomic nitrogen content between 0.78 mol % and 15.21 mol %.[1162]The method according to any of [1] to [1161], wherein the fixing step comprises the use of an atmosphere with an atomic nitrogen content between 4.29 mol % and 49 mol % or less.[1163]The method according to any of [1] to [1162], wherein the fixing step comprises the use of an atmosphere with a nitrogen content of 0.02 wt % or more.[1164]The method according to any of [1] to [1163], wherein the fixing step comprises the use of an atmosphere with a nitrogen content of 3.9 wt % or less.[1165]The method according to any of [1] to [1164], wherein the fixing step comprises the use of an atmosphere with a nitrogen content between 0.2 wt % and 3.9 wt %.[1166]The method according to any of [1] to [1165], wherein the fixing step comprises the use of an atmosphere with an ammonia content which is above 0.1 vol %.[1167]The method according to any of [1] to [1166], wherein the fixing step comprises the use of an atmosphere with an ammonia content which is below 89 vol %.[1168]The method according to any of [1] to [1167], wherein the fixing step comprises the use of an atmosphere comprising an ammonia content which is above 0.11 vol % and below 49%. [1169]The method according to any of [1] to [1168], wherein the percentage of nitrogen at the surface of the component after the fixing step is 0.02 wt % or more.[1170]The method according to any of [1] to [1169], wherein the percentage of nitrogen at the surface of the component after the fixing step is 3.9 wt % or less.[1171]The method according to any of [1] to [1170], wherein the percentage of nitrogen at the surface of the component after the fixing step is between 0.2 wt % and 3.9 wt %.[1172]The method according to any of [1] to [1171], wherein the fixing step comprises the use of an atmosphere with a nitriding potential, kn which is above 0.002 bar¹².[1173]The method according to any of [1] to [1172], wherein the fixing step comprises the use of an atmosphere with a nitriding potential, kn which is below 89 bar^{-½}.[1174]The method according to any of [1] to [1173], wherein the fixing step comprises the use of an atmosphere with a nitriding potential, kn which is above 0.012 bar^{-½}and below 89 bar^{-½}.[1175]The method according to any of [1] to [1174], wherein the fixing step comprises the application of an overpressure of at least 0.0012 bar.[1176]The method according to any of [1] to [1175], wherein the fixing step comprises the application of an overpressure of less than 4800 bar.[1177]The method according to any of [1] to [1176], wherein the fixing step comprises the application of an overpressure of at least 1.7 bar, but less than 740 bar.[1178]The method according to any of [1] to [1177], wherein the fixing step comprises the application of a temperature which is above 220° C.[1179]The method according to any of [1] to [1178], wherein the fixing step comprises the application of a temperature which is above 580° C.[1180]The method according to any of [1] to [1179], wherein the fixing step comprises the application of a temperature which is below 1440° C.[1181]The method according to any of [1] to [1180], wherein the fixing step comprises the application of a temperature which is below 980° C.[1182]The method according to any of [1] to [1181], wherein the fixing step comprises the application of a temperature which is above 655° C. and below 1440° C.[1183]The method according to any of [1] to [1182], wherein in the fixing step comprises the application of a temperature which is above 220° C. and below 790° C.[1184]The method according to any of [1] to [1183], wherein the fixing step comprises the use of an % O₂ comprising atmosphere.[1185]The method according to any of [1] to [1184], wherein the fixing step comprises the use of an % O₂ comprising atmosphere, wherein % O₂ is 0.002 vol % or more.[1186]The method according to any of [1] to [1185], wherein the fixing step comprises the use of an % O₂ comprising atmosphere, wherein % O₂ is 0.02 vol % or more.[1187]The method according to any of [1] to [1186], wherein the fixing step comprises the use of an % O₂ comprising atmosphere, wherein % Oz is 89 vol % or less.[1188]The method according to any of [1] to [1187], wherein the fixing step comprises the use of an % O₂ comprising atmosphere, wherein % O₂ is 49 vol % or less.[1189]The method according to any of [1] to [1188], wherein the fixing step comprises the use of an % O₂ comprising atmosphere at a temperature higher than 55° C. for at least 1 h.[1190]The method according to any of [1] to [1189], wherein the fixing step comprises the use of an % O₂ comprising atmosphere at a temperature lower than 890° C. for less than 90 h.[1191]The method according to any of [1] to [1190], wherein the fixing step comprises the use of an % O₂ comprising atmosphere at a temperature higher than 105° C. for at least 1 h, but less than 90 h,[1192]The method according to any of [1] to [1191], wherein the fixing step comprises the use of at least 2 different atmospheres.[1193]The method according to any of [1] to [1192], wherein the fixing step comprises the use of at least 3 different atmospheres.[1194]The method according to any of [1] to [1193], wherein the fixing step comprises the use of at least 4 different atmospheres.[1195]The method according to any of [1] to [1194], wherein the atmosphere refers to the atmosphere of the furnace or pressure vessel where the fixing step is performed.[1196]The method according to any of [1] to [1195], wherein the fixing step comprises the application of an adequate temperature which is above 220° C. and below 1490° C.[1197]The method according to any of [1] to [1196], wherein the fixing step comprises the application of an adequate temperature which is above 420° C.[1198]The method according to any of [1] to [1197], wherein the fixing step comprises the application of an adequate temperature which is below 1140° C.[1199]The method according to any of [1] to [1198], wherein the % O in the component after the fixing step complies with the formula % Os KYS*(% Y+1.98*% Sc+2.47*% Ti+0.67*% REE).[1200]The method according to any of [1] to [1199], wherein the % O in the component after the fixing step complies with the formula % O≤KYS*(% Y+1.98*% Sc+0.67*% REE).[1201]The method according to any of [1] to [1200], wherein the % O in the component after the fixing step complies with the formula KYI*(% Y+1.98*% Sc+2.47*% Ti+0.67*% REE)<% O KYS*(% Y+1.98*% Sc+2.47*% Ti+0.67*% REE). [1202]The method according to any of [1] to [1201], wherein the % O in the component after the fixing step complies with the formula KYI*(% Y+1.98*% Sc+0.67*% REE)<% O≤KYS*(% Y+1.98*% Sc+0.67*% REE).[1203]The method according to any of [1] to [1202], wherein the percentage of nitrogen at the surface of the component after the fixing step is between 0.02 wt % and 3.9 wt %.[1204]The method according to any of [1] to [1203], wherein the percentage of nitrogen at the surface of the component after the fixing step is 0.2 wt % or more.[1205]The method according to any of [1] to [1204], wherein the percentage of nitrogen at the surface of the component after the fixing step is 2.9 wt % or less.[1206]The method according to any of [1] to [1205], wherein the % NMVS in the metallic part of the component after the fixing step is above 0.02% and below 99.98%.[1207]The method according to any of [1] to [1206], wherein the % NMVS in the metallic part of the component after the fixing step is above 6% and below 99.98%.[1208]The method according to any of [1] to [1207], wherein the % NMVS in the metallic part of the component after the fixing step is above 0.02% and below 99.8%.[1209]The method according to any of [1] to [1208], wherein the % NMVS in the metallic part of the component after the fixing step is above 31%.[1210]The method according to any of [1] to [1209], wherein the % NMVS in the metallic part of the component after the fixing step is above 51%.[1211]The method according to any of [1] to [1210], wherein the % NMVS in the metallic part of the component after the fixing step is above 0.2%.[1212]The method according to any of [1] to [1211], wherein the % NMVS in the metallic part of the component after the fixing step is above 1.1%.[1213] The method according to any of [1] to [1212], wherein the % NMVC in the metallic part of the component after the fixing step is above 0.3% and below 64%. [1214]The method according to any of [1] to [1213], wherein the % NMVC in the metallic part of the component after the fixing step is above 0.4%.[1215]The method according to any of [1] to [1214], wherein the % NMVC in the metallic part of the component after the fixing step is above 1.2%.[1216]The method according to any of [1] to [1215], wherein the % NMVC in the metallic part of the component after the fixing step is above 2.1%.[1217]The method according to any of [1] to [1216], wherein the % NMVC in the metallic part of the component after the fixing step is above 3.2%.[1218]The method according to any of [1] to [1217], wherein the % NMVC in the metallic part of the component after the fixing step is below 49%.[1219]The method according to any of [1] to [1218], wherein the % NMVC in the metallic part of the component after the fixing step is below 39%.[1220]The method according to any of [1] to [1219], wherein the % NMVC in the metallic part of the component after the fixing step is below 24%.[1221]The method according to any of [1] to [1220], wherein the % NMVS in the metallic part of the component after the fixing step is achieved at some point of the consolidation step.[1222]The method according to any of [1] to [1221], wherein the % NMVC in the metallic part of the component after the fixing step is achieved at some point of the consolidation step.[1223]The method according to any of [1] to [1222], wherein the apparent density of the metallic part of the component after the fixing step is achieved at some point of the consolidation step.[1224]The method according to any of [1] to [1223], wherein the method further comprises applying a machining step to the component obtained after the fixing step.[1225]The method according to any of [1] to [1224], wherein the fixing step is mandatory.[1226]The method according to any of [1] to [1225], wherein the fixing step is optional.[1227]The method according to any of [1] to [1226], wherein the fixing step is omitted.[1228]The method according to any of [1] to [1227], wherein the consolidation step comprises a sintering.[1229]The method according to any of [1] to [1228], wherein the consolidation step is a sintering.[1230]The method according to any of [1] to [1229], wherein the sintering technique employed is spark plasma sintering.[1231]The method according to any of [1] to [1230], wherein the consolidation step comprises the application of a high pressure, high temperature cycle where the pressure is strongly variated during the cycle presenting at least two high pressure periods in two different moments in time.[1232]The method according to any of [1] to [1231], wherein the high pressure, high temperature cycle where the pressure is strongly variated during the cycle presenting at least two high pressure periods in two different moments in time comprises the following steps: Step 1: a high pressure and high temperature treatment, Step 2: a moderate pressure high temperature treatment and Step 3: a high pressure and high temperature treatment.[1233]The method according to any of [1] to [1232], wherein, in step 1, a high pressure is between 22 MPa and 1900 MPa.[1234]The method according to any of [1] to [1233], wherein, in step 1, a high pressure is 22 MPa or more.[1235]The method according to any of [1] to [1234], wherein, in step 1, a high pressure is 52 MPa or more.[1236]The method according to any of [1] to [1235], wherein, in step 1, a high pressure is 1900 MPa or less.[1237]The method according to any of [1] to [1236], wherein, in step 1, a high pressure is 890 MPa or less.[1238]The method according to any of [1] to [1237], wherein, in step 2, a moderate pressure is between 1e⁻⁹ mbar and 90 MPa. [1239]The method according to any of [1] to [1238], wherein, in step 2, a moderate pressure is 90 MPa or less.[1240]The method according to any of [1] to [1239], wherein, in step 2, a moderate pressure is 19 MPa or less.[1241]The method according to any of [1] to [1240], wherein, in step 2, a moderate pressure is 1e⁻⁵ mbar or more.[1242]The method according to any of [1] to [1241], wherein, in step 2, a moderate pressure is 0.01 mbar or more.[1243]The method according to any of [1] to [1242], wherein when performing more than one step in the same furnace or pressure vessel, the change of pressure applied is between 0.2 MPa and 890 MPa.[1244]The method according to any of [1] to [1243], wherein when performing more than one step in the same furnace or pressure vessel, the change of pressure applied is 52 MPa or more.[1245]The method according to any of [1] to [124], wherein when performing more than one step in the same furnace or pressure vessel, the change of pressure applied is 380 MPa or less.[1246]The method according to any of [1] to [1245], wherein a high temperature is a temperature between 0.36*Tcm and 2.9*Tcm.[1247]The method according to any of [1] to [1246], wherein a high temperature is 0.46*Tcm or more.[1248]The method according to any of [1] to [1247], wherein a high temperature is 1.9*Tcm or less.[1249]The method according to any of [1] to [1248], wherein a high temperature is 0.99*Tcm or less.[1250]The method according to any of [1] to [1249], wherein Tcm is the melting temperature of the powder with the lowest melting point in the powder mixture.[1251]The method according to any of [1] to [1250], wherein Tcm is Tm.[1252]The method according to any of [1] to [1251], wherein the dwell time in which the temperature is kept within the high temperature range is between 0.1 h and 1900 h.[1253]The method according to any of [1] to [1252], wherein the dwell time in which the temperature is kept within the high temperature range is 0.52 h or more.[1254]The method according to any of [1] to [1253], wherein the dwell time in which the temperature is kept within the high temperature range is 192 h or less.[1255]The method according to any of [1] to [1254], wherein the dwell time in which the pressure is kept within the high pressure range is between 0.01 h and 1700 h.[1256]The method according to any of [1] to [1255], wherein the dwell time in which the pressure is kept within the high pressure range is 0.12 h or more.[1257]The method according to any of [1] to [1256], wherein the dwell time in which the pressure is kept within the high pressure range is 182 h or less.[1258]The method according to any of [1] to [1257], wherein the dwell time in which the pressure is kept within the moderate pressure range is between 0.01 h and 1800 h.[1259]The method according to any of [1] to [1258], wherein the dwell time in which the pressure is kept within the moderate pressure range is 0.12 h or more.[1260]The method according to any of [1] to [1259], wherein the dwell time in which the pressure is kept within the moderate pressure range is 172 h or less.[1261]The method according to any of [1] to [1260], wherein the high pressure, high temperature cycle where the pressure is strongly variated during the cycle presenting at least two high pressure periods in two different moments in time and the consolidation step are performed simultaneously.[1262]The method according to any of [1] to [1261], wherein the consolidation step comprises the use of an atmosphere comprising % N₂.[1263]The method according to any of [1] to [1262], wherein the consolidation step comprises the use of an atmosphere comprising 75 wt % or more % H₂.[1264]The method according to any of [1] to [1263], wherein the consolidation step comprises the use of an atmosphere comprising 55 wt % or more % Ar.[1265]The method according to any of [1] to [1264], wherein the consolidation step comprises the use of an atmosphere with a pH₂/pH₂O which is between 2*10⁻⁸ and 2*10¹³, being pH₂ the partial pressure of H₂ in bar and pH₂O the partial pressure of H₂O in bar.[1266]The method according to any of [1] to [1265], wherein the atmosphere used in the consolidation step is changed from an atmosphere comprising 55 wt % or more % H₂ to an atmosphere comprising 55 wt % or more % Ar.[1267]The method according to any of [1] to [1266], wherein the consolidation step comprises the application of a vacuum with an absolute pressure of 590 mbar or lower.[1268]The method according to any of [1] to [1267], wherein the consolidation step comprises the application of a vacuum with an absolute pressure of 99 mbar or lower.[1269]The method according to any of [1] to [1268], wherein the consolidation step comprises the application of a vacuum with an absolute pressure of 9 mbar or lower.[1270]The method according to any of [1] to [1269], wherein the consolidation step comprises the application of a vacuum with an absolute pressure of 0.9 mbar or lower.[1271]The method according to any of [1] to [1270], wherein the consolidation step comprises the application of a vacuum with an absolute pressure of 0.9*10⁻² mbar or lower.[1772]The method according to any of [1] to [1271], wherein the consolidation step comprises the application of a vacuum with an absolute pressure of 0.9*10⁻³ mbar or lower.[1273]The method according to any of [1] to [1272], wherein the consolidation step comprises the application of a vacuum with an absolute pressure of 0.9*10⁻⁴ mbar or lower.[1274]The method according to any of [1] to [1273], wherein the consolidation step comprises the application of a vacuum with an absolute pressure of 0.9*10⁻⁵ mbar or lower.[1275]The method according to any of [1] to [1274], wherein the consolidation step comprises the application of a vacuum with an absolute pressure of 0.9*10⁶ mbar or lower.[1276]The method according to any of [1] to [1275], wherein the consolidation step comprises the application of a vacuum with an absolute pressure of 0.9*10⁻⁷ mbar or lower.[1277]The method according to any of [1] to [1276], wherein the consolidation step comprises the application of a vacuum with an absolute pressure of 0.9*10⁻¹² mbar or higher.[1278]The method according to any of [1] to [1277], wherein the consolidation step comprises the application of a vacuum with an absolute pressure of 0.9*10⁻¹¹ mbar or higher.[1279]The method according to any of [1] to [1278], wherein the consolidation step comprises the application of a vacuum with an absolute pressure of 1.2*10⁻¹¹ mbar or higher.[1280]The method according to any of [1] to [1279], wherein the consolidation step comprises the application of a vacuum with an absolute pressure of 0.9*10⁻¹⁰ mbar or higher.[1281]The method according to any of [1] to [1280], wherein the consolidation step comprises the application of a vacuum with an absolute pressure of 0.9*10⁻⁹ mbar or higher.[1282]The method according to any of [1] to [1281], wherein the consolidation step comprises the application of a vacuum with an absolute pressure of 1.2*10⁻⁸ mbar or higher.[1283]The method according to any of [1] to [1282], wherein the consolidation step comprises the application of a vacuum with an absolute pressure of 0.9*10⁻⁸ mbar or higher.[1284]The method according to any of [1] to [1283], wherein the consolidation step comprises the application of a vacuum with an absolute pressure of 1.2*10⁻⁶ mbar or higher.[1285]The method according to any of [1] to [1284], wherein the consolidation step comprises the application of a vacuum with an absolute pressure of 1.2*10⁻⁴ mbar or higher.[1286]The method according to any of [1] to [1285], wherein the consolidation step comprises the application of a vacuum with an absolute pressure between 590 mbar and 1.2*10⁻⁸ mbar.[1287]The method according to any of [1] to [1286], wherein the consolidation step comprises the application of a vacuum with an absolute pressure between 99 mbar and 1.2*10⁻⁶ mbar.[1288]The method according to any of [1] to [1287], wherein the consolidation step comprises the application of a vacuum with an absolute pressure between 0.9 mbar and 1.2*10⁻⁴ mbar.[1289]The method according to any of [1] to [1288], wherein the consolidation step comprises the application of a vacuum with an absolute pressure between 0.9*10⁻³ mbar and 0.9*10⁻¹² mbar.[1290]The method according to any of [1] to [1289], wherein the consolidation step comprises the application of a vacuum with an absolute pressure between 0.9*10⁻³ mbar and 0.9*10⁻⁸ mbar.[1291]The method according to any of [1] to [1290], wherein the consolidation step comprises the application of a vacuum with an absolute pressure which is changed from 0.9*10⁻² mbar or higher to 0.9*10⁻³ mbar or lower.[1292]The method according to any of [1] to [1291], wherein the consolidation step comprises the use of an atmosphere with a carbon potential of the furnace or pressure vessel atmosphere in relation to the carbon potential of the surface of the component which is above 0.0001% [1293]The method according to any of [1] to [1292], wherein the consolidation step comprises the use of an atmosphere with a carbon potential of the furnace or pressure vessel atmosphere in relation to the carbon potential of the surface of the component which is above 0.0001% and below 69%.[1294]The method according to any of [1] to [1293], wherein the consolidation step comprises the use of an atmosphere with a carbon potential of the furnace or pressure vessel atmosphere in relation to the carbon content in the metallic part of the component which is above 0.0001%.[1295]The method according to any of [1] to [1294], wherein the consolidation step comprises the use of an atmosphere with a carbon potential of the furnace or pressure vessel atmosphere in relation to the carbon content in the metallic part of the component which is below 69%, [1296]The method according to any of [1] to [1295], wherein the carbon potential of the furnace or pressure vessel atmosphere in relation to the carbon content in the metallic part of the component after the consolidation step is defined as the absolute value of [(carbon content in the metallic part of the component after the consolidation step —carbon potential of the furnace or pressure vessel atmosphere)/carbon potential of the furnace or pressure vessel atmosphere]*100.[1297]The method according to any of [1] to [1296], wherein the consolidation step comprises the use of an atmosphere with an atomic nitrogen content of 0,078 mol % or more.[1298]The method according to any of [1] to [1297], wherein the consolidation step comprises the use of an atmosphere with an atomic nitrogen content of 2.14 mol % or more.[1299]The method according to any of [1] to [1298], wherein the consolidation step comprises the use of an atmosphere with an atomic nitrogen content of 89 mol % or less.[1300]The method according to any of [1] to [1299], wherein the consolidation step comprises the use of an atmosphere with an atomic nitrogen content of 46.8 mol % or less.[1301] The method according to any of [1] to [1300], wherein the consolidation step comprises the use of an atmosphere with an atomic nitrogen content between 0.78 mol % and 15.21 mol %.[1302]The method according to any of [1] to [1301], wherein the consolidation step comprises the use of an atmosphere with an atomic nitrogen content between 4.29 mol % and 69 mol % or less.[1303]The method according to any of [1] to [1302], wherein the consolidation step comprises the use of an atmosphere with a nitrogen content which is 0.02 wt % or more.[1304]The method according to any of [1] to [1303], wherein the consolidation step comprises the use of an atmosphere with a nitrogen content which is 3.9 wt % or less.[1305]The method according to any of [1] to [1304], wherein the consolidation step comprises the use of an atmosphere with a nitrogen content which is between 0.2 wt % and 3.9 wt %.[1306]The method according to any of [1] to [1305], wherein the consolidation step comprises the use of an atmosphere with an ammonia content which is above 0.1 vol %.[1307]The method according to any of [1] to [1306], wherein the consolidation step comprises the use of an atmosphere with an ammonia content which is below 89 vol %.[1308]The method according to any of [1] to [1307], wherein the consolidation step comprises the use of an atmosphere comprising an ammonia content which is above 0.11 vol % and below 49%.[1309]The method according to any of [1] to [1308], wherein the percentage of nitrogen at the surface of the component after the consolidation step is 0.02 wt % or more.[1310]The method according to any of [1] to [1309], wherein the percentage of nitrogen at the surface of the component after the consolidation step is 3.9 wt % or less. [1311]The method according to any of [1] to [1310], wherein the percentage of nitrogen at the surface of the component after the consolidation step is between 0.2 wt % and 3.9 wt %.[1312]The method according to any of [1] to [1311], wherein the consolidation step comprises the use of an atmosphere with a nitriding potential, kn which is above 0.002 bar⁻½.[1313]The method according to any of [1] to [1312], wherein the consolidation step comprises the use of an atmosphere with a nitriding potential, kn which is below 89 bar⁻½.[1314]The method according to any of [1] to [1313], wherein the consolidation step comprises the use of an atmosphere with a nitriding potential, kn which is above 0.012 bar^{-½} and below 89 bar⁻½.[1315]The method according to any of [1] to [1314], wherein the consolidation step comprises the application of an overpressure of at least 0.0012 bar.[1316]The method according to any of [1] to [1315], wherein the consolidation step comprises the application of an overpressure of less than 4800 bar.[1317]The method according to any of [1] to [1316], wherein the consolidation step comprises the application of an overpressure of at least 1.7 bar, but less than 740 bar.[1318]The method according to any of [1] to [1317], wherein the consolidation step comprises the application of a temperature which is above 220° C.[1319]The method according to any of [1] to [1318], wherein the consolidation step comprises the application of a temperature which is above 580° C.[1320]The method according to any of [1] to [1319], wherein the atmosphere used in the consolidation step comprises the application of a temperature which is below 1440° C.[1321]The method according to any of [1] to [1320], wherein the atmosphere used in the consolidation step comprises the application of a temperature which is below 980° C.[1322]The method according to any of [1] to [1321], wherein the consolidation step comprises the application of a temperature which is above 655° C. and below 1440° C.[1323]The method according to any of [1] to [1322], wherein the consolidation step comprises the application of a temperature which is above 220° C. and below 790° C.[1324]The method according to any of [1] to [1323], wherein the consolidation step comprises the use of an % O₂ comprising atmosphere.[1325]The method according to any of [1] to [1324], wherein the consolidation step comprises the use of an % O₂ comprising atmosphere, wherein % O₂ is 0.002 vol % or more.[1326]The method according to any of [1] to [1325], wherein the consolidation step comprises the use of an % O comprising atmosphere, wherein % O₂ is 0.02 vol % or more.[1327]The method according to any of [1] to [1326], wherein the consolidation step comprises the use of an % O₂ comprising atmosphere, wherein % O₂ is 89 vol % or less.[1328]The method according to any of [1] to [1327], wherein the consolidation step comprises the use of an % O₂ comprising atmosphere, wherein % O₂ is 49 vol % or less.[1329]The method according to any of [1] to [1328], wherein the consolidation stop comprises the use of an % O₂ comprising atmosphere at a temperature higher than 55° C. for at least 1 h.[1330]The method according to any of [1] to [1329], wherein the consolidation step comprises the use of an % Oz comprising atmosphere at a temperature lower than 890° C. for less than 90 h.[1331]The method according to any of [1] to [1330], wherein the consolidation stop comprises the use of an % % O₂ comprising atmosphere at a temperature higher than 105° C. for at least 1 h, but less than 90 h.[1332]The method according to any of [1] to [1331], wherein the consolidation step comprises the application of at least 2 different atmospheres.[1333]The method according to any of [1] to [1332], wherein the consolidation step comprises the application of at least 3 different atmospheres.[1334]The method according to any of [1] to [1333], wherein the consolidation step comprises the application of at least 4 different atmospheres.[1335]The method according to any of [1] to [1334], wherein the atmosphere refers to the atmosphere of the furnace or pressure vessel where the consolidation step is performed.[1336]The method according to any of [1] to [1335], wherein the consolidation step comprises the use of the same atmosphere used in the fixing step.[1337]The method according to any of [1] to [1336], wherein the mean pressure applied in the consolidation step is at least at least 0.01 bar. [1338]The method according to any of [1] to [1337], wherein the minimum pressure applied in the consolidation step is at least 10 mbar. [1339]The method according to any of [1] to [1338], wherein the minimum pressure applied in the consolidation step is at least 0.1 bar.[1340]The method according to any of [1] to [1339], wherein the minimum pressure applied in the consolidation step is at least 1.6 bar. [1341]The method according to any of [1] to [1340], wherein the minimum pressure applied in the consolidation step is less than 89 bar.[1342]The method according to any of [1] to [1341], wherein the mean pressure applied in the consolidation step is at least 0.1 bar and less than 4900 bar.[1343]The method according to any of [1] to [1342], wherein the mean pressure applied in the consolidation step is less than 790 bar.[1344]The method according to any of [1] to [1343], wherein the mean pressure applied in the consolidation step is less than 790 bar, wherein the mean pressure is calculated excluding any pressure which is maintained for less than 29 seconds.[1345]The method according to any of [1] to [1344], wherein the maximum temperature in the consolidation step is between 0.36*Tm and 0.96*Tm. [1346]The method according to any of [1] to [1345], wherein the maximum temperature in the consolidation step is 0.46*Tm or more.[1347]The method according to any of [1] to [1346], wherein the mean temperature in the consolidation step is between 0.38*Tm and 0.96*Tm.[1348]The method according to any of [1] to [1347], wherein the mean temperature in the consolidation step is 0.46*Tm or more.[1349]The method according to any of [1] to [1348], wherein the maximum temperature in the consolidation step is 0.96*Tm or more.[1350]The method according to any of [1] to [1349], wherein the mean temperature in the consolidation step is 1.9*Tm or less.[1351]The method according to any of [1] to [1350], wherein the maximum temperature in the consolidation step is between Tm and 1.49*Tm.[1352]The method according to any of [1] to [1351], wherein the maximum temperature in the consolidation step is Tm+22 or more.[1353]The method according to any of [1] to [1352], wherein the mean temperature in the consolidation step is Tm+890 or less.[1354]The method according to any of [1] to [1353], wherein the maximum temperature in the consolidation step is between Tm+11 and Tm+450.[1355]The method according to any of [1] to [1354], wherein the maximum liquid phase during the consolidation step is above 0.2 vol %.[1356]The method according to any of [1] to [1355], wherein the maximum liquid phase during the consolidation step is maintained below 39 vol %.[1357]The method according to any of [1] to [1356], wherein the % NMVS in the metallic part of the component after the consolidation step is above 0.02%.[1358]The method according to any of [1] to [1357], wherein the % NMVS in the metallic part of the component after the consolidation step is above 0.02% and below 39%.[1359]The method according to any of [1] to [1358], wherein the % NMVS in the metallic part of the component after the consolidation step is below 24%.[1360]The method according to any of [1] to [1359], wherein the % NMVS in the metallic part of the component after the consolidation step is below 14%.[1361]The method according to any of [1] to [1360], wherein the % NMVS in the metallic part of the component after the consolidation step is above 0.06%.[1362]The method according to any of [1] to [1361], wherein the % NMVS in the metallic part of the component after the consolidation step is above 0.06% and below 14%.[1363]The method according to any of [1] to [1362], wherein the % NMVS in the metallic part of the component after the consolidation step is above 0.2%.[1364]The method according to any of [1] to [1363], wherein the percentage of reduction of NMVS in the metallic part of the component after the consolidation step is above 0.12%.[1365]The method according to any of [1] to [1364], wherein the percentage of reduction of NMVS in the metallic part of the component after the consolidation step is above 0.6%.[1366]The method according to any of [1] to [1365], wherein the percentage of reduction of NMVS in the metallic part of the component after the consolidation step is above 2.1%.[1367]The method according to any of [1] to [1366], wherein the percentage of reduction of NMVS in the metallic part of the component after the consolidation step is above 6%.[1368]The method according to any of [1] to [1367], wherein the % NMVC in the metallic part of the component after the consolidation step is above 0.002%.[1369]The method according to any of [1] to [1368], wherein the % NMVC in the metallic part of the component after the consolidation step is below 9%.[1370]The method according to any of [1] to [1369], wherein the % NMVC in the metallic part of the component after the consolidation step is above 0.002% and below 9%.[1371]The method according to any of [1] to [1370], wherein the % NMVC in the metallic part of the component after the consolidation step is below 4%.[1372]The method according to any of [1] to [1371], wherein the % NMVC in the metallic part of the component after the consolidation step is below 0.9%.[1373]The method according to any of [1] to [1372], wherein the % NMVC in the metallic part of the component after the consolidation step is above 0.006%.[1374]The method according to any of [1] to [1373], wherein the % NMVC in the metallic part of the component after the consolidation step is above 0.02%.[1375]The method according to any of [1] to [1374], wherein the apparent density of the metallic part of the component after the consolidation step is less than 99.8%.[1376]The method according to any of [1] to [1375], wherein the apparent density of the metallic part of the component after the consolidation step is higher than 81% and less than 99.8%.[1377]The method according to any of [1] to [1376], wherein the apparent density of the metallic part of the component after the consolidation step is less than 99.4%.[1378]The method according to any of [1] to [1377], wherein the apparent density of the metallic part of the component after the consolidation step is less than 98.9%.[1379]The method according to any of [1] to [1378], wherein the apparent density of the metallic part of the component after the consolidation step is higher than 81%.[1380]The method according to any of [1] to [1379], wherein the apparent density of the metallic part of the component after the consolidation step is higher than 86%. [1381]The method according to any of [1] to [1380], wherein the apparent density of the metallic part of the component after the consolidation step is higher than 91%.[1382]The method according to any of [1] to [1381], wherein the percentage of increase of apparent density of the metallic part of the component after the consolidation step is above 6% and below 69%.[1383]The method according to any of [1] to [1382], wherein the percentage of increase of apparent density of the metallic part of the component after the consolidation step is above 11%.[1384]The method according to any of [1] to [1383], wherein the percentage of increase of apparent density of the metallic part of the component after the consolidation step is above 16%.[1385]The method according to any of [1] to [1384], wherein the percentage of increase of apparent density of the metallic part of the component after the consolidation step is and below 59%.[1386]The method according to any of [1] to [1385], wherein the percentage of increase of apparent density of the metallic part of the component after the consolidation step is and below 49%.[1387]The method according to any of [1] to [1386], wherein the percentage of increase of apparent density of the metallic part of the component after the consolidation step is and below 29%.[1388]The method according to any of [1] to [1387], wherein the percentage of increase of apparent density of the metallic part of the component after the consolidation step is and below 19%.[1389]The method according to any of [1] to [1388], wherein the method further comprises applying a machining step to the component obtained after the consolidation step.[1390]The method according to any of [1] to [1389], wherein the method further comprises applying a heat treatment to the component obtained after the consolidation step.[1391]The method according to any of [1] to [1390], wherein the method further comprises the step of: joint different parts to make a bigger component after applying the densification step.[1392]The method according to any of [1] to [1391], wherein at least two parts comprising a metal are joined to manufacture a larger component. [1393]The method according to any of [1] to [1392], wherein at least three parts comprising a metal are joined to manufacture a larger component.[1394]The method according to any of [1] to [1393], wherein at least two parts are joined to manufacture a larger component, being at least one part manufactured according to the method of any of [1] to [1393]. [1395]The method according to any of [1] to [1394], wherein at least three parts are joined to manufacture a larger component, being at least one part manufactured according to the method of any of [1] to [1394]. [1396]The method according to any of [1] to [1395], wherein at least three parts are joined to manufacture a larger component, being at least two parts manufactured according to the method of any of [1] to [1395].[1397]The method according to any of [1] to [1396], wherein at least two parts manufactured according to the method of any of [1] to [1396] are joined together to manufacture a larger component.[1398]The method according to any of [1] to [1397], wherein at least three parts manufactured according to the method of any of [1] to [1397] are joined together to manufacture a larger component. The method according to any of [1] to [1398], wherein at least five parts manufactured according to the method of any of [1] to [1398] are joined together to manufacture a larger component.[1400]The method according to any of [1] to [1399], wherein at least some of the surfaces of the different parts coming together are removed from oxides prior to joining.[1401]The method according to any of [1] to [1400], wherein at least some of the surfaces of the different parts coming together are removed from organic products prior to joining.[1402]The method according to any of [1] to [1401], wherein at least some of the surfaces of the different parts coming together are removed from dust prior to joining.[1403]The method according to any of [1] to [1402], wherein some of the surfaces is at least one of the surfaces.[1404]The method according to any of [1] to [1403], wherein at least two of the surfaces.[1405]The method according to any of [1] to [1404], wherein at least some of the surfaces is at least part of the surfaces of the different parts coming together.[1406]The method according to any of [1] to [1405], wherein the step of joint different parts comprises pulling the surfaces together with 0.01 MPa or more.[1407]The method according to any of [1] to [1406], wherein the step of joint different parts comprises pulling the surfaces together with 12 MPa or more.[1408]The method according to any of [1] to [1407], wherein the step of joint different parts comprises pulling the surfaces together with 1.2 MPa or more.[1409]The method according to any of [1] to [1408], wherein the joining of the parts is made through welding.[1410]The method according to any of [1] to [1409], wherein the joining of the parts comprises plasma-arc heating. [1411]The method according to any of [1] to [1410], wherein the joining of the parts comprises electric-arc heating. [1412]The method according to any of [1] to [1411], wherein the joining of the parts comprises laser heating.[1413]The method according to any of [1] to [1412], wherein the joining of the parts comprises electron beam heating.[1414]The method according to any of [1] to [1413], wherein the joining of the parts comprises oxy-fuel heating.[1415]The method according to any of [1] to [1414], wherein the joining of the parts comprises resistance heating.[1416]The method according to any of [1] to [1415], wherein the joining of the parts comprises induction heating.[1417]The method according to any of [1] to [1416], wherein the joining of the parts comprises ultrasound heating.[1418]The method according to any of [1] to [1417], wherein the joining of the part comprises make a thin welding whose only purpose is to keep the parts together on the joining surfaces for them to diffusion weld in the densification treatment.[1419]The method according to any of [1] to [1418], wherein a joining is performed with a high temperature glue.[1420]The method according to any of [1] to [1419], wherein the parts to be joined together have a guiding mechanism to position with the right reference against each other.[1421]The method according to any of [1] to [1420], wherein the joining is made in a vacuum environment of 900 mbar or less.[1422]The method according to any of [1] to [1421], wherein the joining is made in a vacuum environment of 0.09 mbar or less.[1423]The method according to any of [1] to [1422], wherein the joining is made in a vacuum environment of 10⁻¹¹ mbar or more.[1424]The method according to any of [1] to [1423], wherein the joining is made in a vacuum environment of 10⁻⁹ mbar or more.[1425]The method according to any of [1] to [1424], wherein the joining is made in a vacuum environment of 10⁻⁷ mbar or more.[1426]The method according to any of [1] to [1425], wherein the joining is made in an oxygen free environment.[1427]The method according to any of [1] to [1426], wherein the joining is made in an environment with an oxygen content of 9 wt % or less.[1428]The method according to any of [1] to [1427], wherein the joining is made in an environment with an oxygen content of 90 ppm or less.[1429]The method according to any of [1] to [1428], wherein the joining is made in an environment with an oxygen content of 0.9 ppm or less.[1430]The method according to any of [1] to [1429], wherein the joining is made in an environment with an oxygen content of 9 vol % or less.[1431]The method according to any of [1] to [1430], wherein the joining is made in an environment with an oxygen content of 90 ppm by volume or less.[1432]The method according to any of [1] to [1431], wherein the joining is made in an environment with an oxygen content of 0.9 ppm by volume or less.[1433]The method according to any of [1] to [1432], wherein the joining is done all around the periphery of the faces touching each other of at least two of the components coming together in a gas tight way. [1434]The method according to any of [1] to [1433], wherein a gas tight way means that when the joined component is introduced in a fluid and a high pressure is applied, this fluid cannot flow in the spaces and/or micro-cavities between the two facing each other and joined through all the periphery surfaces of each of the two components assembled together.[1435]The method according to any of [1] to [1434], wherein a gas tight way means that when the joined component is introduced in a fluid and a pressure of 52 MPa or more is applied, this fluid cannot flow in the spaces and/or micro-cavities between the two facing each other and joined through all the periphery surfaces of each of the two components assembled together.[1436]The method according to any of [1] to [1435], wherein a gas tight way means that when the joined component is introduced in a fluid and a pressure of 152 MPa or more is applied, this fluid cannot flow in the spaces and/or micro-cavities between the two facing each other and joined through all the periphery surfaces of each of the two components assembled together.[1437]The method according to any of [1] to [1436], wherein a gas tight way means that when the joined component is introduced in a fluid and a pressure of 202 MPa or more is applied, this fluid cannot flow in the spaces and/or micro-cavities between the two facing each other and joined through all the periphery surfaces of each of the two components assembled together.[1438]The method according to any of [1] to [1437], wherein a gas tight way means that when the joined component is introduced in a fluid and a pressure of 252 MPa or more is applied, this fluid cannot flow in the spaces and/or micro-cavities between the two facing each other and joined through all the periphery surfaces of each of the two components assembled together.[1439]The method according to any of [1] to [1438], wherein a gas tight way means that when the joined component is introduced in a fluid and a pressure of 555 MPa or more is applied, this fluid cannot flow in the spaces and/or micro-cavities between the two facing each other and joined through all the periphery surfaces of each of the two components assembled together.[1440]The method according to any of [1] to [1439], wherein at least in some areas, the critical depth of weld is small enough.[1441]The method according to any of [1] to [1440], wherein the critical depth of weld is small enough in at least 6% of the welding line in the periphery of two faces coming together.[1442]The method according to any of [1] to [1441], wherein the critical depth of weld is small enough in at least 16% of the welding line in the periphery of two faces coming together.[1443]The method according to any of [1] to [1442], wherein the critical depth of weld is small enough in at least 56% of the welding line in the periphery of two faces coming together.[1444]The method according to any of [1] to [1443], wherein the critical depth of weld refers to the mean value of depth of weld in the length considered.[1445]The method according to any of [1] to [1444], wherein the critical depth of weld refers to the weighted —through length-mean value of depth of weld in the length considered.[1446]The method according to any of [1] to [1445], wherein the critical depth of weld refers to the maximum value of depth of weld in the length considered.[1447] The method according to any of [1] to [1446], wherein the critical depth of weld refers to the minimum value of depth of weld in the length considered.[1448]The method according to any of [1] to [1447], wherein the critical depth of the weld refers to the extension in depth of the molten zone of the weld.[1449]The method according to any of [1] to [1448], wherein the critical depth of the weld refers to the extension in depth of the molten zone of the weld evaluated in the cross-section.[1450]The method according to any of [1] to [1449], wherein the critical depth of the weld refers to the extension in depth of the heat affected zone (HAZ) of the weld. [1451]The method according to any of [1] to [1450], wherein the critical depth of the weld refers to the extension in depth of the HAZ of the weld evaluated in the cross-section.[1452]The method according to any of [1] to [1451], wherein small enough critical depth of weld is 19 mm or less.[1453]The method according to any of [1] to [1452], wherein small enough critical depth of weld is 3.8 mm or less.[1454]The method according to any of [1] to [1453], wherein small enough critical depth of weld is 0.4 mm or less. [1455]The method according to any of [1] to [1454], wherein the power density of the heat source is kept below 900 W/mm³.[1456]The method according to any of [1] to [1455], wherein the power density of the heat source is kept below 90 W/mm³.[1457]The method according to any of [1] to [1456], wherein the power density of the heat source is kept below 0.9 W/mm³.[1458]The method according to any of [1] to [1457], wherein the % O in the component after the consolidation step complies with the formula % O≤KYS*(% Y+1.98*% Sc+2.47*% Ti+0.67*% REE).[1459]The method according to any of [1] to [1458], wherein the % O in the component after the consolidation step complies with the formula % O≤KYS*(% Y+1.98*% Sc+0.67*% REE).[1460]The method according to any of [1] to [1459], wherein the % O in the component after the consolidation step complies with the formula KYI*(% Y+1.98*% Sc+2.47*% Ti+0.67*% REE)<O≤KYS*(% Y+1.98*% Sc+2.47*% Ti+0.67*% REE). [1461]The method according to any of [1] to [1460], wherein the % O in the component after the consolidation step complies with the formula KYI*(% Y+1.98*% Sc+0.67*% REE)<% O≤KYS*(% Y+1.98*% Sc+0.67*% REE).[1462]The method according to any of [1] to[1461], wherein the consolidation step is mandatory.[1463]The method according to any of [1] to [1462], wherein the consolidation step is optional.[1464]The method according to any of [1] to [1463], wherein the consolidation step is omitted.[1465]The method according to any of [1] to [1464], wherein the apparent density of the metallic part of the component after the forming step is higher than 51% and wherein the apparent density of the metallic part of the component after the consolidation step is higher than 81%.[1466]The method according to any of [1] to [1465], wherein the apparent density of the metallic part of the component after the forming step is higher than 51% and less than 96.9% and wherein the apparent density of the metallic part of the component after the consolidation step is higher than 81% and less than 99.8%.[1467]The method according to any of [1] to [1466], wherein the % NMVS in the metallic part of the component after the forming step is above 12% and wherein the % NMVS in the metallic part of the component after the consolidation step is below 24%.[1468]The method according to any of [1] to [1467], wherein the % NMVS in the metallic part of the component after the forming step is above 31% and below 98% and wherein the % NMVS in the metallic part of the component after the consolidation step is above 0.02% and below 24%.[1469]The method according to any of [1] to [1468], wherein the % NMVC in the metallic part of the component after the forming step is below 49% and wherein the % NMVC in the metallic part of the component after the consolidation step is below 9%.[1470]The method according to any of [1] to [1469], wherein the % NMVC in the metallic part of the component after the forming step is above 3.2% and below 24%; and wherein the % NMVC in the metallic part of the component after the consolidation step is above 0.002% and below 0.9%.[1471]The method according to any of [1] to [1470], wherein the % NMVC in the metallic part of the component after the forming step is above 6.2% and below 49% and wherein the % NMVC in the metallic part of the component after the consolidation step is below 4%.[1472]The method according to any of [1] to [1471], wherein the % NMVS in the metallic part of the component after the forming step is above 0.02% and below 99.8%; wherein the % NMVC in the metallic part of the component after the forming step is above 0.3% and below 64%; wherein the % NMVS in the metallic part of the component after the consolidation step is above 0.02% and below 39% and wherein the % NMVC in the metallic part of the component after the consolidation step is above 0.002% and below 9%.[1473]The method according to any of [1] to [1472], wherein the % NMVS in the metallic part of the component after the forming step is above 1.1% and below 99.8%; wherein the % NMVC in the metallic part of the component after the forming step is above 1.2% and below 64%; wherein the % NMVS in the metallic part of the component after the consolidation step is above 0.06% and below 24% and wherein the % NMVC in the metallic part of the component after the consolidation step is above 0.002% and below 4%.[1474]The method according to any of [1] to [1473], wherein the method further comprises the step of: joint different parts to make a bigger component before the densification step.[1475]The method according to any of [1] to [1474], wherein the densification step comprises a hot isostatic pressing (HIP).[1476]The method according to any of [1] to [1475], wherein the densification step is a hot isostatic pressing (HIP).[1477]The method according to any of [1] to [1476], wherein the densification step comprises the application of a high pressure, high temperature cycle where the pressure is strongly variated during the cycle presenting at least two high pressure periods in two different moments in time.[1478]The method according to any of [1] to [1477], wherein the high pressure, high temperature cycle where the pressure is strongly variated during the cycle presenting at least two high pressure periods in two different moments in time and the densification step are performed simultaneously.[1479]The method according to any of [1] to [1478], wherein the high pressure, high temperature cycle where the pressure is strongly variated during the cycle presenting at least two high pressure periods in two different moments in time, the consolidation step and the consolidation step are performed simultaneously.[1480]The method according to any of [1] to [1479], wherein the densification step comprises the use of an atmosphere comprising % N₂.[1481]The method according to any of [1] to [1480], wherein the densification step comprises the use of an atmosphere comprising % H₂.[1482] The method according to any of [1] to [1481], wherein the densification step comprises the use of an atmosphere comprising 55 wt % or more % Ar.[1483] The method according to any of [1] to [1482], wherein the densification step comprises the use of an atmosphere with a pH₂/pH₂O which is between 2*10⁻⁸ and 2*10¹³, being pH₂ the partial pressure of H₂ in bar and pH₂O the partial pressure of H₂O in bar.[1484]The method according to any of [1] to [1483], wherein the atmosphere used in the densification step is changed from an atmosphere comprising 55 wt % or more % H₂ to an atmosphere comprising 55 wt % or more % Ar.[1485]The method according to any of [1] to [1484], wherein the densification step comprises the application of a vacuum with an absolute pressure of 590 mbar or lower.[1486]The method according to any of [1] to [1485], wherein the densification step comprises the application of a vacuum with an absolute pressure between 0.9 mbar and 1.2*10⁻¹⁰ mbar.[1487]The method according to any of [1] to [1486], wherein the densification step comprises the application of a vacuum with an absolute pressure between 0.9*10⁻³ mbar and 0.9*10⁻¹² mbar.[1488]The method according to any of [1] to [1487], wherein the atmosphere used in the densification step comprises the application of a vacuum with an absolute pressure which is changed from 0.9*10⁻² mbar or higher to 0.9*10⁻³ mbar or lower.[1489]The method according to any of [1] to [1488], wherein the densification step comprises the use of an atmosphere with a carbon potential of the furnace or pressure vessel atmosphere in relation to the carbon potential of the surface of the component which is above 0.0001%.[1490] The method according to any of [1] to [1489], wherein the densification step comprises the use of an atmosphere with a carbon potential of the furnace or pressure vessel atmosphere in relation to the carbon potential of the surface of the component which is above 0.0001% and below 69%.[1491]The method according to any of [1] to [1490], wherein the densification step comprises the use of an atmosphere with a carbon potential of the furnace or pressure vessel atmosphere in relation to the carbon content in the metallic part of the component which is above 0.0001%.[1492]The method according to any of [1] to [1491], wherein the densification step comprises the use of an atmosphere with a carbon potential of the furnace or pressure vessel atmosphere in relation to the carbon content in the metallic part of the component which is below 69%, [1493]The method according to any of [1] to [1492], wherein the carbon potential of the furnace or pressure vessel atmosphere in relation to the carbon content in the metallic part of the component after the densification step is defined as the absolute value of [(carbon content in the metallic part of the component after the densification step —carbon potential of the furnace or pressure vessel atmosphere)/carbon potential of the furnace or pressure vessel atmosphere]*100.[1494]The method according to any of [1] to [1493], wherein the densification step comprises the use of an atmosphere with an atomic nitrogen content of 0.078 mol % or more.[1495]The method according to any of [1] to [1494], wherein the densification step comprises the use of an atmosphere with an atomic nitrogen content of 2.14 mol % or more.[1496]The method according to any of [1] to [1495], wherein the densification step comprises the use of an atmosphere with an atomic nitrogen content of 89 mol % or less.[1497]The method according to any of [1] to [1496], wherein the densification step comprises the use of an atmosphere with an atomic nitrogen content of 46.8 mol % or less. [1498]The method according to any of [1] to [1497], wherein the densification step comprises the use of an atmosphere with an atomic nitrogen content between 0.78 mol % and 15.21 mol %.[1499]The method according to any of [1] to [1498], wherein the densification step comprises the use of an atmosphere with an atomic nitrogen content between 4.29 mol % and 69 mol % or less.[1500]The method according to any of [1] to [1499], wherein the densification step comprises the use of an atmosphere with a nitrogen content which is 0.02 wt % or more.[1501]The method according to any of [1] to [1500], wherein the densification step comprises the use of an atmosphere with a nitrogen content which is 3.9 wt % or less.[1502]The method according to any of [1] to [1501], wherein the densification step comprises the use of an atmosphere with a nitrogen content which is between 0.2 wt % and 3.9 wt %.[1503]The method according to any of [1] to [1502], wherein the densification step comprises the use of an atmosphere with an ammonia content which is above 0.1 vol %. [1504]The method according to any of [1] to [1503], wherein the densification step comprises the use of an atmosphere with an ammonia content which is below 89 vol %.[1505]The method according to any of [1] to [1504], wherein the densification step comprises the use of an atmosphere comprising an ammonia content which is above 0.11 vol % and below 49 vol %.[1506]The method according to any of [1] to [1505], wherein the percentage of nitrogen at the surface of the component after the densification step is between 0.02 wt % and 3.9 wt %.[1507]The method according to any of [1] to [1506], wherein the percentage of nitrogen at the surface of the component after the densification step is 0.2 wt % or more.[1508]The method according to any of [1] to [1507], wherein the percentage of nitrogen at the surface of the component after the densification step is 2.9 wt % or less.[1509]The method according to any of [1] to [1508], wherein the densification step comprises the use of an atmosphere with a nitriding potential, kn which is above 0.002 bar².[1510]The method according to any of [1] to [1509], wherein the densification step comprises the use of an atmosphere with a nitriding potential, kn which is below 89 bar⁻½.[1511]The method according to any of [1] to [1510], wherein the densification step comprises the use of an atmosphere with a nitriding potential, kn which is above 0.012 bar^{-½} and below 89 bar⁻½. [1512]The method according to any of [1] to [1511], wherein the densification step comprises the application of an overpressure of at least 0.0012 bar.[1513]The method according to any of [1] to [1512], wherein the densification step comprises the application of an overpressure of less than 4800 bar.[1514]The method according to any of [1] to [1513], wherein the densification step comprises the application of an overpressure of at least 1.7 bar, but less than 740 bar.[1515]The method according to any of [1] to [1514], wherein the densification step comprises the application of a temperature which is above 220° C.[1516]The method according to any of [1] to [1515], wherein the densification step comprises the application of a temperature which is above 580° C.[1517]The method according to any of [1] to [1516], wherein the densification step comprises the application of a temperature which is below 1440° C.[1518]The method according to any of [1] to [1517], wherein the densification step comprises the application of a temperature which is below 980° C.[1519]The method according to any of [1] to [1518], wherein the densification step comprises the application of a temperature which is above 655° C. and below 1440° C.[1520]The method according to any of [1] to [1519], wherein the densification step comprises the application of a temperature which is above 220° C. and below 790° C.[1521]The method according to any of [1] to [1520], wherein the densification step comprises the use of an % O₂ comprising atmosphere.[1522]The method according to any of [1] to [1521], wherein the densification step comprises the use of an % O₂ comprising atmosphere, wherein % O₂ is 0.002 vol % or more.[1523]The method according to any of [1] to [1522], wherein the densification step comprises the use of an % O₂ comprising atmosphere, wherein % O₂ is 0.02 vol % or more.[1524]The method according to any of [1] to [1523], wherein the densification step comprises the use of an % O₂ comprising atmosphere, wherein % O₂ is 89 vol % or less.[1525]The method according to any of [1] to [1524], wherein the densification step comprises the use of an % O₂ comprising atmosphere, wherein % O₂ is 49 vol % or less.[1526]The method according to any of [1] to [1525], wherein the densification step comprises the use of an % O₂ comprising atmosphere at a temperature higher than 55° C. for at least 1 h.[1527]The method according to any of [1] to [1526], wherein the densification step comprises the use of an % O₂ comprising atmosphere at a temperature lower than 890° C. for less than 90 h.[1528]The method according to any of [1] to [1527], wherein the densification step comprises the use of an % O₂ comprising atmosphere at a temperature higher than 105° C. for at least 1 h, but less than 90 h.[1529]The method according to any of [1] to [1528], wherein the densification step comprises the application of at least 2 different atmospheres.[1530]The method according to any of [1] to [1529], wherein the densification step comprises the application of at least 3 different atmospheres.[1531]The method according to any of [1] to [1530], wherein the densification step comprises the application of at least 4 different atmospheres. [1532]The method according to any of [1] to [1531], wherein the densification step comprises the use of the same atmosphere used in the fixing step and/or in the consolidation step.[1533]The method according to any of [1] to [1532], wherein the atmosphere refers to the atmosphere of the furnace or pressure vessel where the densification step is performed.[1534]The method according to any of [1] to [1533], wherein the densification step comprises applying a fast enough cooling. [1535]The method according to any of [1] to [1534], wherein the densification step and the fast enough cooling are performed simultaneously. [1536]The method according to any of [1] to [1535], wherein the densification step and the fast enough cooling are performed in the same furnace or pressure vessel.[1537]The method according to any of [1] to [1536], wherein the maximum pressure applied in the densification step is more than 160 bar and less than 4900 bar.[1538]The method according to any of [1] to [1537], wherein the maximum pressure applied in the densification step is 320 bar or more.[1539]The method according to any of [1] to [1538], wherein the maximum pressure applied in the densification step is 560 bar or more.[1540]The method according to any of [1] to [1539], wherein the maximum pressure applied in the densification step is less than 2800 bar.[1541]The method according to any of [1] to [1540], wherein the maximum pressure applied in the densification step is less than 2200 bar.[1542]The method according to any of [1] to [1541], wherein the mean pressure applied in the densification step is more than 160 bar and less than 4900 bar.[1543]The method according to any of [1] to [1542], wherein the mean pressure applied in the densification step is 320 bar or more.[1544]The method according to any of [1] to[1543], wherein the mean pressure applied in the densification step is 560 bar or more.[1545]The method according to any of [1] to [1544], wherein the mean pressure applied in the densification step is less than 2800 bar.[1546]The method according to any of [1] to [1545], wherein the mean pressure applied in the densification step is less than 2200 bar.[1547]The method according to any of [1] to [1546], wherein the maximum temperature in the densification step is between 0.45*Tm and 0.92*Tm.[1548]The method according to any of [1] to [1547], wherein the maximum temperature in the densification step is 0.55*Tm or more. [1549]The method according to any of [1] to [1548], wherein the maximum temperature in the densification step is 0.65*Tm or more.[1550]The method according to any of [1] to [1549], wherein the mean temperature in the densification step is 0.88*Tm or less.[1551]The method according to any of [1] to [1550], wherein the mean temperature in the densification step is 0.78*Tm or less.[1552] The method according to any of [1] to [1551], wherein the heating in the densification step is at least partially made with microwaves.[1553]The method according to any of [1] to [1552], wherein the heating in the densification step is made with microwaves.[1554]The method according to any of [1] to [1553], wherein the densification step comprises a microwave heating.[1555]The method according to any of [1] to [1554], wherein the densification step comprises applying the pressure in a homogeneous way.[1556]The method according to any of [1] to [1555], wherein the apparent density of the metallic part of the component after the densification step is higher than 96%.[1557]The method according to any of [1] to [1556], wherein the apparent density of the metallic part of the component after the densification step is less than 99.98%.[1558]The method according to any of [1] to [1557], wherein the apparent density of the metallic part of the component after the densification step is higher than 96% and less than 99.98%.[1559]The method according to any of [1] to [1558], wherein the apparent density of the metallic part of the component after the densification step is less than 99.94%.[1560]The method according to any of [1] to [1559], wherein the apparent density of the metallic part of the component after the densification step is less than 99.89%.[1561]The method according to any of [1] to [1560], wherein the apparent density of the metallic part of the component after the densification step is higher than 98.2%.[1562]The method according to any of [1] to [1561], wherein the apparent density of the metallic part of the component after the densification step is higher than 99.2%.[1563]The method according to any of [1] to [1562], wherein the apparent density of the metallic part of the component after the densification step is full density.[1564]The method according to any of [1] to [1563], wherein the apparent density after the densification step is higher than 96%.[1565]The method according to any of [1] to [1564], wherein the apparent density after the densification step is full density.[1566]The method according to any of [1] to [1565], wherein the percentage of increase of apparent density after the densification step is above 6% and below 69%.[1567]The method according to any of [1] to [1566], wherein the percentage of increase of apparent density after the densification step is above 6%.[1568]The method according to any of [1] to [1567], wherein the percentage of increase of apparent density after the densification step is above 11%.[1569]The method according to any of [1] to [1568], wherein the percentage of increase of apparent density after the densification step is above 16%.[1570]The method according to any of [1] to [1569], wherein the percentage of increase of apparent density after the densification step is below 59%.[1571]The method according to any of [1] to [1570], wherein the percentage of increase of apparent density after the densification step is below 49%.[1572]The method according to any of [1] to [1571], wherein the % NMVS after the densification step is above 0.002% k and below 29%.[1573]The method according to any of [1] to [1572], wherein the % NMVS after the densification step is above 0.01%.[1574]The method according to any of [1] to [1573], wherein the % NMVS after the densification step is above 0.06%.[1575]The method according to any of [1] to [1574], wherein the % NMVS after the densification step is below 19%.[1576]The method according to any of [1] to [1575], wherein the % NMVS after the densification step is below 9%.[1577]The method according to any of [1] to[1576], wherein the % NMVS after the densification step is 0%.[1578]The method according to any of [1] to [1577], wherein the percentage of reduction of NMVS after the densification step is above 0.02%.[1579]The method according to any of [1] to [1578], wherein the percentage of reduction of NMVS after the densification step is above 0.22%.[1580]The method according to any of [1] to [1579], wherein the percentage of reduction of NMVS after the densification step is above 3.6%.[1581]The method according to any of [1] to [1580], wherein the percentage of reduction of NMVS after the densification step is above 8%.[1582]The method according to any of [1] to [1581], wherein the % NMVC after the densification step is above 0.002% and below 9%.[1583]The method according to any of [1] to [1582], wherein the % NMVC after the densification step is above 0.006%.[1584]The method according to any of [1] to [1583], wherein the % NMVC after the densification step is above 0.01%,[1585]The method according to any of [1] to [1584], wherein the % NMVC after the densification step is below 1.9%.[1586]The method according to any of [1] to [1585], wherein the % NMVC after the densification step is below 0.8%.[1587]The method according to any of [1] to [1586], wherein the % NMVC after the densification step is 0%.[1588]The method according to any of [1] to [1587], wherein the percentage of reduction of NMVC after the densification step is above 0.06%.[1589]The method according to any of [1] to [1588], wherein the percentage of reduction of NMVC after the densification step is above 0.12%.[1590]The method according to any of [1] to [1589], wherein the percentage of reduction of NMVC after the densification step is above 3.6%.[1591]The method according to any of [1] to [1590], wherein the percentage of reduction of NMVC after the densification step is above 8%.[1592]The method according to any of [1] to [1591], wherein the method further comprises applying a heat treatment to the component obtained after the densification step.[1593]The method according to any of [1] to [1592], wherein the heat treatment comprises a thermo-mechanical a treatment.[1594]The method according to any of [1] to [1593], wherein the heat treatment comprises at least one phase change.[1595]The method according to any of [1] to [1594], wherein the heat treatment comprises at least two phase changes.[1596]The method according to any of [1] to [1595], wherein the heat treatment comprises at least three phase changes.[1597]The method according to any of [1] to [1596], wherein the heat treatment comprises austenitization.[1598]The method according to any of [1] to [1597], wherein the heat treatment comprises solubilization.[1599]The method according to any of [1] to [1598], wherein the heat treatment comprises solubilization of a phase.[1600]The method according to any of [1] to [1599], wherein the heat treatment comprises solubilization of an intermetallic phase.[1601]The method according to any of [1] to [1600], wherein the heat treatment comprises solubilization of carbides.[1602]The method according to any of [1] to [1601], wherein the heat treatment comprises a high temperature exposition.[1603]The method according to any of [1] to [1602], wherein high temperature means 0.52*Tm or more.[1604]The method according to any of [1] to [1603], wherein the heat treatment comprises applying a controlled cooling to the component.[1605]The method according to any of [1] to [1604], wherein the heat treatment comprises quenching the component.[1606]The method according to any of [1] to [1605], wherein a heat treatment comprising a partial phase transformation is applied to the components.[1607]The method according to any of [1] to [1606], wherein the heat treatment comprises martensite transformation.[1608]The method according to any of [1] to [1607], wherein the heat treatment comprises bainitic transformation.[1609]The method according to any of [1] to [1608], wherein the heat treatment comprises a precipitation transformation.[1610] The method according to any of [1] to [1609], wherein the heat treatment comprises precipitation of intermetallic phases. [1611]The method according to any of [1] to [1610], wherein the heat treatment comprises a carbide precipitation transformation.[1612]The method according to any of [1] to [1611], wherein the heat treatment comprises an aging transformation.[1613]The method according to any of [1] to [1612], wherein the heat treatment comprises recrystallization transformation.[1614]The method according to any of [1] to [1613], wherein the heat treatment comprises a spheroidization transformation.[1615]The method according to any of [1] to [1614], wherein the heat treatment comprises an anneal transformation. [1616]The method according to any of [1] to [1615], wherein the heat treatment comprises a tempering transformation.[1617]The method according to any of [1] to [1616], wherein the heat treatment comprises applying a fast enough cooling.[1618] The method according to any of [1] to [1617], wherein the fast enough cooling is implemented by convection with a colder fluid. The method according to any of [1] to [1618], wherein the colder fluid comprises a gas.[1620]The method according to any of [1] to [1619], wherein the colder fluid is more than 50 vol % a gas.[1621]The method according to any of [1] to [1620], wherein the colder fluid comprises a liquid.[1622]The method according to any of [1] to [1621], wherein the colder fluid is more than 50 vol % a liquid.[1623]The method according to any of [1] to [1622], wherein the colder fluid comprises Ar.[1624]The method according to any of [1] to [1623], wherein the colder fluid comprises He.[1625]The method according to any of [1] to [1624], wherein the colder fluid comprises nitrogen.[1626]The method according to any of [1] to [1625], wherein the colder fluid comprises hydrogen.[1627]The method according to any of [1] to [1626], wherein the colder fluid comprises a molten salt,[1628]The method according to any of [1] to [1627], wherein the colder fluid comprises water.[1629]The method according to any of [1] to [1628], wherein the colder fluid comprises water vapor.[1630]The method according to any of [1] to [1629], wherein the colder fluid comprises methane.[1631]The method according to any of [1] to [1630], wherein the colder fluid comprises an organic component.[1632]The method according to any of [1] to [1631], wherein the colder fluid is at least partially replaced by a fluidized bed of solid particles.[1633]The method according to any of [1] to [1632], wherein a colder fluid is a fluid with a mean temperature at least 55° C. lower than the maximum temperature achieved by the component being heat treated.[1634]The method according to any of [1] to [1633], wherein a colder fluid is a fluid with a mean temperature at least 155° C. lower than the maximum temperature achieved by the component being heat treated.[1635]The method according to any of [1] to [1634], wherein a colder fluid is a fluid with a mean temperature at most 3555° C. lower than the maximum temperature achieved by the component being heat treated.[1636]The method according to any of [1] to [1635], wherein a colder fluid is a fluid with a mean temperature at most 2555° C. lower than the maximum temperature achieved by the component being heat treated.[1637]The method according to any of [1] to [1636], wherein the colder fluid is pressurized to 2.1 bar or more and less than 98 bar.[1638]The method according to any of [1] to [1637], wherein the colder fluid is pressurized to 6.1 bar or more.[1639] The method according to any of [1] to [1638], wherein the colder fluid is pressurized to less than 48 bar.[1640] The method according to any of [1] to [1639], wherein the colder fluid is pressurized to 120 bar or more and less than 22000 bar.[1641]The method according to any of [1] to [1640], wherein the colder fluid is pressurized to 520 bar or more.[1642]The method according to any of [1] to [1641], wherein the colder fluid is pressurized to less than 12000 bar.[1643]The method according to any of [1] to [1642], wherein pressurized refers to the maximum pressure of the fluid inside the chamber where the cooling of the component takes place.[1644]The method according to any of [1] to [1643], wherein pressurized refers to the mean maximum pressure of the fluid inside the chamber where the cooling of the component takes place.[1645]The method according to any of [1] to [1644], wherein the mean is calculated for the 2 minutes where the pressure is highest.[1646]The method according to any of [1] to [1645], wherein the mean is calculated for the 5 minutes where the pressure is highest.[1647]The method according to any of [1] to [1646], wherein the fast enough cooling comprises a cooling rate between 1.2 K/min and 1020 K/s or higher.[1648]The method according to any of [1] to [1647], wherein the fast enough cooling comprises a cooling rate of 1.2 K/s or higher.[1649]The method according to any of [1] to [1648], wherein the fast enough cooling comprises a cooling rate of 490 K/s or lower.[1650]The method according to any of [1] to [1649], wherein the cooling rate refers to the maximum cooling rate throughout the process.[1651] The method according to any of [1] to [1650], wherein the cooling rate of the component is the maximum value of cooling rate simulated in the whole process.[1652]The method according to any of [1] to [1651], wherein the cooling rate of the component is the mean value of the cooling rate.[1653]The method according to any of [1] to [1652], wherein the mean value of the cooling rate is calculated in the interval where the maximum temperature of the component is between 700° C. and 400° C.[1654]The method according to any of [1] to [1653], wherein the mean value of the cooling rate is calculated in the interval where the maximum temperature of the component is between 560° C. and 500° C.[1655]The method according to any of [1] to [1654], wherein the heat transference coefficient at the colder fluid-component interface is the maximum theoretical value of heat transference coefficient.[1656]The method according to any of [1] to [1655], wherein the simulation of the heat transference coefficient is done by means of finite element simulation (FEM) and artificial neural network (ANN) [as done in Prediction of heat transfer coefficient during quenching of large size forged blocks using modeling and experimental validation—by Yassine Bouissa et al.].[1657]The method according to any of [1] to [1656], wherein at least two cycles of fast enough cooling are performed.[1658]The method according to any of [1] to [1657], wherein the method further comprises the step of: performing a surface conditioning. [1659]The method according to any of [1] to [1658], wherein the method further comprises the step of: performing a surface conditioning after the heat treatment.[1660]The method according to any of [1] to [1659], wherein the surface conditioning comprises a chemical modification of at least some of the surface of the component. [1661]The method according to any of [1] to [1660], wherein at least part of the surface of the component is altered in a way that the chemical composition changes.[1662] The method according to any of [1] to [1661], wherein the surface conditioning comprises a change in composition of the component.[1663]The method according to any of [1] to [1662], wherein the change in composition is achieved by reaction to an atmosphere.[1664]The method according to any of [1] to [1663], wherein the change in composition is achieved by carburation.[1665]The method according to any of [1] to [1664], wherein the change in composition is achieved by nitriding.[1666]The method according to any of [1] to [1665], wherein the change in composition is achieved by oxidation.[1667]The method according to any of [1] to [1666], wherein the change in composition is achieved by borurizing.[1668]The method according to any of [1] to [1667], wherein the change in composition is achieved by sulfonizing.[1669]The method according to any of [1] to [1668], wherein the change in composition affects % C.[1670]The method according to any of [1] to [1669], wherein the change in composition affects % N.[1671]The method according to any of [1] to [1670], wherein the change in composition affects % B.[1672]The method according to any of [1] to [1671], wherein the change in composition affects % O.[1673]The method according to any of [1] to [1672], wherein the change in composition affects % S.[1674]The method according to any of [1] to [1673], wherein the change in composition affects at least two of % B, % C, % N, % S and % O.[1675]The method according to any of [1] to [1674], wherein the change in composition affects at least three of % B, % C, % N, % S and % O.[1676]The method according to any of [1] to [1675], wherein the change in composition affects at least one of % C, % N, % B, % O and/or % S.[1677]The method according to any of [1] to [1676], wherein the change in composition is achieved by implanting of atoms.[1678]The method according to any of [1] to [1677], wherein the change in composition is achieved through ion bombardment.[1679]The method according to any of [1] to [1678], wherein the change in composition is achieved by deposition of a layer.[1680]The method according to any of [1] to [1679], wherein the change in composition is achieved by growth of a layer.[1681]The method according to any of [1] to [1680], wherein the change in composition is achieved by chemical vapor deposition (CVD).[1682]The method according to any of [1] to [1681], wherein the change in composition is achieved by growth of a layer through hard plating.[1683]The method according to any of [1] to [1682], wherein the change in composition is achieved by hard-chroming.[1684]The method according to any of [1] to [1683], wherein the change in composition is achieved by electro-plating.[1685]The method according to any of [1] to [1684], wherein the change in composition is achieved by hard-chroming.[1686]The method according to any of [1] to [1685], wherein the change in composition is achieved by electrolytic deposition.[1687]The method according to any of [1] to [1686], wherein the change in composition is achieved by physical vapor deposition (PVD).[1688]The method according to any of [1] to [1687], wherein the change in composition is achieved by a dense coating.[1689]The method according to any of [1] to [1688], wherein the change in composition is achieved by high power Impulse magnetron sputtering (HIPIMS).[1690]The method according to any of [1] to [1689], wherein the change in composition is achieved by high energy arc plasma acceleration deposition.[1691]The method according to any of [1] to [1690], wherein the change in composition is achieved by a thick coating.[1692]The method according to any of [1] to [1691], wherein the change in composition is achieved by deposition of a layer through acceleration of particles against the surface.[1693]The method according to any of [1] to [1692], wherein the change in composition is achieved by thermal spraying.[1694]The method according to any of [1] to [1693], wherein the change in composition is achieved by cold spray.[1695]The method according to any of [1] to [1694], wherein the change in composition is achieved by deposition of a layer through a chemical reaction of a paint.[1696]The method according to any of [1] to [1695], wherein the change in composition is achieved by deposition of a layer through a chemical reaction of a spray.[1697]The method according to any of [1] to [1696], wherein the change in composition is achieved by drying of an applied paint or spray. The method according to any of [1] to [1697], wherein the change in composition is achieved through a sol-gel reaction.[1699]The method according to any of [1] to [1698], wherein the superficial layer causing the change in composition is of ceramic nature.[1700]The method according to any of [1] to [1699], wherein the superficial layer causing the change in composition comprises a ceramic material. [1701]The method according to any of [1] to [1700], wherein the superficial layer causing the change in composition comprises an oxide.[1702]The method according to any of [1] to [1701], wherein the superficial layer causing the change in composition comprises a carbide.[1703]The method according to any of [1] to [1702], wherein the superficial layer causing the change in composition comprises a nitride. [1704]The method according to any of [1] to [1703], wherein the superficial layer causing the change in composition comprises a boride.[1705]The method according to any of [1] to [1704], wherein the superficial layer causing the change in composition is of intermetallic nature.[1706]The method according to any of [1] to [1705], wherein the superficial layer causing the change in composition comprises an intermetallic material.[1707]The method according to any of [1] to [1706], wherein the superficial layer causing the change in composition comprises a higher % Ti than any of the underlying materials. [1708]The method according to any of [1] to [1707], wherein the superficial layer causing the change in composition comprises a higher % Cr than any of the underlying materials.[1709]The method according to any of [1] to [1708], wherein the superficial layer causing the change in composition comprises a higher % Al than any of the underlying materials.[1710]The method according to any of [1] to [1709], wherein the superficial layer causing the change in composition comprises a higher % Si than any of the underlying materials.[1711]The method according to any of [1] to [1710], wherein the superficial layer causing the change in composition comprises a higher % Ba than any of the underlying materials.[1712]The method according to any of [1] to [1711], wherein the superficial layer causing the change in composition comprises a higher % Sr than any of the underlying materials.[1713]The method according to any of [1] to [1712], wherein the superficial layer causing the change in composition comprises a higher % Ni than any of the underlying materials. [1714]The method according to any of [1] to [1713], wherein the superficial layer causing the change in composition comprises a higher % V than any of the underlying materials. [1715]The method according to any of [1] to [1714], wherein when referring to underlying materials it is restricted to any material in direct contact with the layer.[1716]The method according to any of [1] to [1715], wherein an underlying material is all the materials comprised in the manufactured component.[1717]The method according to any of [1] to [1716], wherein the superficial layer causing the change in composition is a coating.[1718]The method according to any of [1] to [1717], wherein oxide coatings are employed, like aluminum, zirconium, lanthanum, calcium, and other white oxides.[1719]The method according to any of [1] to [1718], wherein dark oxides are employed, like for example titanium.[1720]The method according to any of [1] to [1719], wherein a coating comprising oxygen and at least one of the following elements: % Cr, % Al, % Si, % Ti, % Y, % La, % Ca, % Zr, % Hf, % Ba, % Sr is employed.[1721]The method according to any of [1] to [1720], wherein a coating comprising oxygen and at least two of the following elements: % Cr, % Al, % Si, % Ti, % Y, % La, % Ca, % Zr, % Hf, % Ba, % Sr is employed.[1722]The method according to any of [1] to [1721], wherein nitride coatings are employed.[1723]The method according to any of [1] to [1722], wherein boride coatings are employed.[1724]The method according to any of [1] to [1723], wherein a coating comprising nitrogen and at least one of the following elements: % Cr, % Al, % Si, % Ti, % V is employed.[1725]The method according to any of [1] to [1724], wherein a coating comprising nitrogen and at least two of the following elements: % Cr, % Al, % Si, % Ti, % V is employed.[1726]The method according to any of [1] to [1725], wherein a coating comprising carbon and at least one of the following elements: % Cr, % Al, % Si, % Ti, % V is employed.[1727]The method according to any of [1] to [1726], wherein a coating comprising carbon and at least two of the following elements: % Cr, % Al, % Si, % Ti, % V is employed.[1728]The method according to any of [1] to [1727], wherein a coating comprising boron and at least one of the following elements: % Cr, % Al, % Si, % Ti, % V is employed.[1729]The method according to any of [1] to [1728], wherein a coating comprising boron and at least two of the following elements: % Cr, % Al, % Si, % Ti, % V is employed.[1730]The method according to any of [1] to [1729], wherein the coating is based on titanates such as barium or strontium titanates.[1731]The method according to any of [1] to [1730], wherein at least a part of the working surface is coated with barium titanate.[1732]The method according to any of [1] to [1731], wherein at least a part of the working surface is coated with strontium titanate.[1733]The method according to any of [1] to [1732], wherein at least a part of the working surface is coated with a barium-strontium titanate.[1734]The method according to any of [1] to [1733], wherein a morphologically similar coating is employed.[1735]The method according to any of [1] to [1734], wherein a functionally similar coating material is employed.[1736]The method according to any of [1] to [1735], wherein the method further comprises applying a machining step to the component.[1737]The method according to any of [1] to [1736], wherein a functionally similar material is one where at least two of the following properties of the coating: the elastic modulus, the fracture toughness and/or the wettability angle.[1738]The method according to any of [1] to [1737], wherein the tool material is kept at 150° C. and the casted alloy 50° C. above its melting temperature, the contact angle hysteresis of the cast alloy on the coating applied to the chosen tool material where the tool material is kept at 150° C. and the casted alloy 50° C. above its melting temperature and electrical resistivity.[1739]The method according to any of [1] to [1738], wherein the tool material is kept within a range of +/−45% of the values obtained for barium titanate.[1740]The method according to any of [1] to [1739], wherein the tool material properties are kept similar to strontium titanate instead of barium titanate.[1741]The method according to any of [1] to [1740], wherein the surface conditioning comprises a physical modification of at least some of the surface of the manufactured component.[1742]The method according to any of [1] to [1741], wherein the surface conditioning comprises a change in the surface roughness.[1743]The method according to any of [1] to [1742], wherein the surface conditioning comprises a change in the surface roughness to an intended level.[1744]The method according to any of [1] to [1743], wherein the surface conditioning comprises a mechanical operation on the surface.[1745]The method according to any of [1] to [1744], wherein the surface conditioning comprises a polishing operation. [1746]The method according to any of [1] to [1745], wherein the surface conditioning comprises a lapping operation.[1747]The method according to any of [1] to [1746], wherein the surface conditioning comprises an electro-polishing operation.[1748]The method according to any of [1] to [1747], wherein the surface conditioning comprises a mechanical operation on the surface which also leaves residual stresses on the surface.[1749]The method according to any of [1] to [1748], wherein at least some of the residual stresses are compressive.[1750]The method according to any of [1] to [1749], wherein the surface conditioning comprises a shot-penning operation. The method according to any of [1] to [1749], wherein the surface conditioning comprises a ball-blasting operation.[1751]The method according to any of [1] to [1750], wherein the surface conditioning comprises a texturing operation on the surface.[1752]The method according to any of [1] to [1751], wherein the surface conditioning comprises a tailored texturing operation on the surface.[1753]The method according to any of [1] to [1752], wherein the surface conditioning comprises a texturing operation on the surface providing at least two different texturing patterns in different areas of the surface.[1754]The method according to any of [1] to [1753], wherein the surface conditioning comprises an etching operation.[1755]The method according to any of [1] to [1754], wherein the surface conditioning comprises a chemical etching operation.[1756]The method according to any of [1] to [1755], wherein the surface conditioning comprises a beam etching operation.[1757]The method according to any of [1] to [1756], wherein the surface conditioning comprises an electron-beam etching operation.[1758]The method according to any of [1] to [1757], wherein the surface conditioning comprises a laser-beam etching operation.[1759]The method according to any of [1] to [1758], wherein the texturing is done through laser engraving.[1760]The method according to any of [1] to [1759], wherein the texturing is done through electron-beam engraving.[1761]The method according to any of [1] to [1760], wherein the surface conditioning comprises both a physical and a chemical modification of at least some of the surface of the component.[1762]The method according to any of [1] to [1761], wherein the surface conditioning comprises a coating and a texturing operation on it.[1763]The method according to any of [1] to [1762], wherein the texturing is made on a chemically modified surface.[1764]The method according to any of [1] to [1763], wherein the texturing is made on an applied coating.[1765]The method according to any of [1] to [1764], wherein the engraving is made on an applied coating.[1766]The method according to any of [1] to [1765], wherein the etching is made on an applied coating.[1767]The method according to any of [1] to [1766], wherein the densification step is mandatory.[1768]The method according to any of [1] to [1767], wherein the densification step is omitted.[1769]The method according to any of [1] to [1768], wherein the densification step is optional.[1770]The method according to any of [1] to [1769], wherein the heat treatment is mandatory.[1771]The method according to any of [1] to [1770], wherein the machining is mandatory.[1772]The method according to any of [1] to [1771], wherein the apparent density of the metallic part of the component after the forming step is higher than 51%: wherein the apparent density of the metallic part of the component after the consolidation step is higher than 81% and wherein the apparent density of the metallic part of the component after the densification step is higher than 96%.[1773]The method according to any of [1] to [1772], wherein the apparent density of the metallic part of the component after the forming step is higher than 51% and less than 99.8%; wherein the apparent density of the metallic part of the component after the consolidation step is higher than 81% and less than 99.8% and wherein and the apparent density of the metallic part of the component after the densification step is higher than 96% and less than 99.98%.[1774]The method according to any of [1] to [1773], wherein the apparent density of the metallic part of the component after the forming step is higher than 51% and less than 99.8%; wherein the apparent density of the metallic part of the component after the consolidation step is higher than 81% and less than 99.8% and wherein the apparent density of the metallic part of the component after the densification step is higher than 96%.[1775]The method according to any of [1] to [1774], wherein the component comprises at least 2 materials with different composition.[1776]The method according to any of [1] to [1775], wherein the component comprises at least 3 materials with different composition.[1777]The method according to any of [1] to [1776], wherein the apparent density of the metallic part of the component is full density.[1778]The method according to any of [1] to [1777], wherein the % NMVS in the metallic part of the component is 0%.[1779]The method according to any of [1] to [1778], wherein the % NMVC in the metallic part of the component is 0%.[1780]The method according to any of [1] to [1779], wherein the % Yeq(1) content in the component is higher than 0.03 wt % and lower than 8.9 wt %.[1781]The method according to any of [1] to [1780], wherein the % Yeq(1) content in the component is higher than 0.03 wt %.[1782]The method according to any of [1] to [1781], wherein the % Yeq(1) content in the component is lower than 4.9 wt %.[1783]The method according to any of [1] to [1782], wherein the % Yeq(1) content in the component refers to the % Yeq(1) content in at least one of the materials comprised in the component.[1784]The method according to any of [1] to [1783], wherein % YEQ(1)=% Y+1.55*(% Sc+% Ti)+0.68*% REE.[1785]The method according to any of [1] to [1784], wherein % YEQ(1)=% Y+1.55*% Sc+0.68*% REE.[1786]The method according to any of [1] to [1785], wherein the component has the composition of a nitrogen austenitic steel.[1787]The method according to any of [1] to [1786], wherein the nitrogen austenitic steel, is an steel with the following composition, all percentages in wt %: Mo: 0-6.8; % W: 0-6.9; % Moeq: 0-6.8; % Ceq: 0.16-1.8; % C: 0-1.29; % N: 0.11-2.09; % B: 0-0.14; % Si: 0-1.5; % Mn: 0-24; % Ni: 0-18.9; % Cr: 12.1-38; % Ti: 0-2.4; % Al: 0-14; % V: 0-4; % Nb: 0-4; % Zr: 0-3: % Hf: 0-3: % Ta: 0-3: % S: 0-0.098; % P: 0-0.098; % Pb: 0-0.9; % Cu: 0-3.9; % Bi: 0-0.08; % Se: 0-0.08; % Co: 0-14: % REE: 0-4; % Y: 0-1.86; % Sc: 0-0.96: % Cs: 0-1.4: % O: 0.00012-0.899; % Y+% Sc+% REE: 0.0022-3.9%; the rest consisting of iron and trace elements, being the sum of all trace elements below 2.0; wherein % Ceq-% C+0.86*% N+1.2*% B and % Moeq=% Mo+W % W.[1788]The method according to any of [1] to [1787], wherein the content of % V+% Al+% Cr+% Mo+% Ta+% W+% Nb in the component is between 0.12 wt % and 34 wt %.[1789]The method according to any of [1] to [1788], wherein the content of % V+% Al+% Cr+% Mo+% Ta+% W+% Nb in the component refers to the content of % V+% Al+% Cr+% Mo+% Ta+% W+% Nb in at least one of the materials comprised in the component.[1790]The method according to any of [1] to [1789], the oxygen content in the component is more than 0.02 ppm and less than 390 ppm. [1791]The method according to any of [1] to [1790], the oxygen content in the component is more than 0.2 ppm.[1792]The method according to any of [1] to [1791], the oxygen content in the component is less than 140 ppm.[1793]The method according to any of [1] to [1792], wherein the nitrogen content in the component is more than 0.01 ppm and less than 99 ppm.[1794]The method according to any of [1] to [1793], wherein the nitrogen content in the component is more than 0.06 ppm.[1795]The method according to any of [1] to [1794], wherein the nitrogen content in the component is less than 49 ppm.[1796]The method according to any of [1] to [1795], wherein the oxygen content in the component is more than 0.02 ppm and less than 390 ppm and the nitrogen level of the component is between 0.01 ppm and 99 ppm.[1797]The method according to any of [1] to [1796], the oxygen content in the component is more than 260 ppm and less than 19000 ppm. [1798]The method according to any of [1] to [1797], wherein the oxygen content in the component is more than 520 ppm.[1799]The method according to any of [1] to [1798], the oxygen content in the component is less than 14000 ppm.[1800]The method according to any of [1] to [1799], wherein the nitrogen content in the component is between 0.02 wt % and 3.9 wt %.[1801]The method according to any of [1] to [1800], wherein the nitrogen content in the component is 2.9 wt % or less.[1802]The method according to any of [1] to [1801], wherein the nitrogen content in the component is 0.2 wt % or more.[1803]The method according to any of [1] to [1802], wherein the oxygen content in the component is more than 260 ppm and less than 19000 ppm and the nitrogen level of the component is between 0.02 wt % and 3.9 wt %.[1804]The method according to any of [1] to [1803], wherein the oxygen content in the component refers to the oxygen content in at least one of the materials comprised in the component.[1805]The method according to any of [1] to [1804], wherein the nitrogen content in the component refers to the nitrogen content in at least one of the materials comprised in the component.[1806]The method according to any of [1] to [1805], wherein the % Yeq(1) content in the component is higher than 0.03 wt % and lower than 8.9 wt %.[1807]The method according to any of [1] to [1806], wherein the % Yeq(1) content in the component is higher than 0.06 wt %.[1808]The method according to any of [1] to [1807], wherein the % Yeq(1) content in the component is higher than 1.2 wt %.[1809]The method according to any of [1] to [1808], wherein the % Yeq(1) content in the component is lower than 4.9 wt %.[1810]The method according to any of [1] to [1809], wherein the % Yeq(1) content in the component refers to the % Yeq(1) content in at least one of the materials comprised in the component.[1811]The method according to any of [1] to [1810], wherein the % O in the component complies with the formula % O≤KYS*(% Y+1.98*% Sc+2.47*% Ti+0.67*% REE).[1812]The method according to any of [1] to [1811], wherein the % O in the component complies with the formula % O≤KYS*(% Y+1.98*% Sc+0.67*% REE).[1813]The method according to any of [1] to [1812], wherein the % O in the component complies with the formula KYI*(% Y+1.98*% Sc+2.47*% Ti+0.67*% REE)<% O≤KYS*(% Y+1.98*% Sc+2.47*% Ti+0.67*% REE).[1814]The method according to any of [1] to [1813], wherein the % O in the component complies with the formula KYI*(% Y+1.98*% Sc+0.67*% REE)<% O≤KYS*(% Y+1.98*% Sc+0.67*% REE).[1815]The method according to any of [1] to [1814], wherein the % O in the component refers to the oxygen content in at least one of the materials comprised in the component,[1816]The method according to any of [1] to [1815], wherein KYS is 2100.[1817]The method according to any of [1] to [1816], wherein KYS is 2350.[1818]The method according to any of [1] to [1817], wherein KYI is 3800.[1819]The method according to any of [1] to [1818], wherein KYI is 2900. [1820]The method according to any of [1] to [1819], wherein the component is the component obtained after the consolidation step.[1821]The method according to any of [1] to [1820], wherein the component is the component obtained after the densification step.[1822]The method according to any of [1] to [1821], wherein the volume of the component is more than 2% and less than 89% of the volume of the rectangular cuboid with the minimum possible volume which contains the component.[1823]The method according to any of [1] to [1822], wherein the volume of the component is less than 89% of the volume of the rectangular cuboid with the minimum possible volume which contains the component.[1824]The method according to any of [1] to [1823], wherein the volume of the component is less than 74% of the volume of the rectangular cuboid with the minimum possible volume which contains the component.[1825]The method according to any of [1] to [1824], wherein the volume of the component is less than 68% of the volume of the rectangular cuboid with the minimum possible volume which contains the component.[1826]The method according to any of [1] to [1825], wherein the volume of the component is less than 49% of the volume of the rectangular cuboid with the minimum possible volume which contains the component.[1827]The method according to any of [1] to [1826], wherein the volume of the component is less than 29% of the volume of the rectangular cuboid with the minimum possible volume which contains the component.[1828]The method according to any of [1] to [1827], wherein the volume of the component is less than 19% of the volume of the rectangular cuboid with the minimum possible volume which contains the component.[1829]The method according to any of [1] to [1828], wherein the volume of the component is more than 2% of the volume of the rectangular cuboid with the minimum possible volume which contains the component.[1830]The method according to any of [1] to [1829], wherein the volume of the component is more than 6% of the volume of the rectangular cuboid with the minimum possible volume which contains the component.[1831]The method according to any of [1] to [1830], wherein the volume of the component is more than 12% of the volume of the rectangular cuboid with the minimum possible volume which contains the component.[1832]The method according to any of [1] to [1831], wherein the volume of the component is more than 22% k of the volume of the rectangular cuboid with the minimum possible volume which contains the component.[1833]The method according to any of [1] to [1832], wherein the volume of the component is more than 44% of the volume of the rectangular cuboid with the minimum possible volume which contains the component.[1834]The method according to any of [1] to [1833], wherein the volume of the component is more than 49% of the volume of the rectangular cuboid with the minimum possible volume which contains the component.[1835]The method according to any of [1] to [1834], wherein the volume of the component is more than 55% of the volume of the rectangular cuboid with the minimum possible volume which contains the component.[1836]The method according to any of [1] to [1835], wherein the volume of the component is more than 2% and less than 89% of the volume of the cuboid shaped with the working surface of the component.[1837]The method according to any of [1] to [1836], wherein the volume of the component is less than 89% of the volume of the cuboid shaped with the working surface of the component.[1838]The method according to any of [1] to [1837], wherein the volume of the component is less than 74% of the volume of the cuboid shaped with the working surface of the component.[1839]The method according to any of [1] to [1838], wherein the volume of the component is less than 68% of the volume of the cuboid shaped with the working surface of the component.[1840]The method according to any of [1] to [1839], wherein the volume of the component is less than 49% of the volume of the cuboid shaped with the working surface of the component.[1841]The method according to any of [1] to [1840], wherein the volume of the component is less than 29% of the volume of the cuboid shaped with the working surface of the component.[1842]The method according to any of [1] to [1841], wherein the volume of the component is less than 19% of the volume of the cuboid shaped with the working surface of the component. [1843]The method according to any of [1] to [1842], wherein the volume of the component is more than 2% of the volume of the cuboid shaped with the working surface of the component.[1844]The method according to any of [1] to [1843], wherein the volume of the component is more than 6% of the volume of the cuboid shaped with the working surface of the component.[1845]The method according to any of [1] to [1844], wherein the volume of the component is more than 12% of the volume of the cuboid shaped with the working surface of the component.[1846]The method according to any of [1] to [1845], wherein the volume of the component is more than 22% of the volume of the cuboid shaped with the working surface of the component[1847]The method according to any of [1] to [1846], wherein the volume of the component is more than 44% of the volume of the cuboid shaped with the working surface of the component.[1848]The method according to any of [1] to [1847], wherein the volume of the component is more than 49% of the volume of the cuboid shaped with the working surface of the component.[1849]The method according to any of [1] to [1848], wherein the volume of the component is more than 55% of the volume of the cuboid shaped with the working surface of the component.[1850]The method according to any of [1] to [1849], wherein the cuboid shaped with the working surface of the component is defined as the rectangular cuboid with the minimum possible volume which contains the component, wherein the face of the rectangular cuboid that is in contact with the working surface of the component is substituted by a face with a geometrical shape that is coincident with the geometrical shape of the working surface of the component and has the minimum possible area.[1851]The method according to any of [1] to [1850], wherein the working surface is the active surface.[1852]The method according to any of [1] to [1851], wherein the working surface is the relevant active surface.[1853]The method according to any of [1] to [1852], wherein the significant cross-section of the component is more than 0.2 mm² and less than 2900000 mm². [1854]The method according to any of [1] to [1853], wherein the significant cross-section of the component is more than 0.2 mm².[1855]The method according to any of [1] to [1854], wherein the significant cross-section of the component is more than 2 mm².[1856]The method according to any of [1] to [1855], wherein the significant cross-section of the component is more than 20 mm².[1857]The method according to any of [1] to [1856], wherein the significant cross-section of the component is more than 200 mm².[1858]The method according to any of [1] to [1857], wherein the significant cross-section of the component is more than 2000 mm².[1859]The method according to any of [1] to [1858], wherein the significant cross-section of the component is less than 2900000 mm². [1860]The method according to any of [1] to [1859], wherein the significant cross-section of the component is less than 900000 mm². [1861]The method according to any of [1] to [1860], wherein the significant cross-section of the component is less than 400000 mm². [1862]The method according to any of [1] to [1861], wherein the significant cross-section of the component is less than 90000 mm². [1863]The method according to any of [1] to [1862], wherein the significant cross-section of the component is less than 40000 mm². [1864]The method according to any of [1] to [1863], wherein the significant cross-section of the component is less than 29000 mm². [1865]The method according to any of [1] to [1864], wherein the significant cross-section of the component is less than 9000 mm². [1866]The method according to any of [1] to [1865], wherein the significant cross-section of the component is less than 4900 mm². [1867]The method according to any of [1] to [1866], wherein the significant cross-section of the component is less than 2400 mm².[1868]The method according to any of [1] to [1867], wherein the significant cross-section of the component is less than 900 mm².[1869]The method according to any of [1] to [1868], wherein the significant cross-section of the component is less than 400 mm².[1870]The method according to any of [1] to [1869], wherein the significant cross-section of the component is less than 190 mm².[1871]The method according to any of [1] to [1870], wherein the significant cross-section of the component is less than 90 mm².[1872]The method according to any of [1] to [1871], wherein the significant cross-section of the component is less than 40 mm².[1873]The method according to any of [1] to [1872], wherein the significant cross-section of the component is 0.79 times or less the area of the largest rectangular face of the rectangular cuboid with the minimum possible volume which contains the component. [1874]The method according to any of [1] to [1873], wherein the significant cross-section of the component is 0.69 times or less the area of the largest rectangular face of the rectangular cuboid with the minimum possible volume which contains the component.[1875]The method according to any of [1] to [1874], wherein the significant cross-section of the component is 0.59 times or less the area of the largest rectangular face of the rectangular cuboid with the minimum possible volume which contains the component.[1876]The method according to any of [1] to [1875], wherein the significant cross-section of the component is 0.49 times or less the area of the largest rectangular face of the rectangular cuboid with the minimum possible volume which contains the component.[1877]The method according to any of [1] to [1876], wherein the significant cross-section of the component is 0.39 times or less the area of the largest rectangular face of the rectangular cuboid with the minimum possible volume which contains the component.[1878]The method according to any of [1] to [1877], wherein the significant cross-section of the component is 0.29 times or less the area of the largest rectangular face of the rectangular cuboid with the minimum possible volume which contains the component.[1879]The method according to any of [1] to [1878], wherein the significant cross-section of the component is 0.19 times or less the area of the largest rectangular face of the rectangular cuboid with the minimum possible volume which contains the component.[1880]The method according to any of [1] to [1879], wherein the significant cross-section of the component is 0.09 times or loss the area of the largest rectangular face of the rectangular cuboid with the minimum possible volume which contains the component.[1881]The method according to any of [1] to [1880], wherein the significant cross-section of the component is 0.04 times or less the area of the largest rectangular face of the rectangular cuboid with the minimum possible volume which contains the component. [1882] The method according to any of [1] to [1881], wherein the significant cross-section of the component is 0.019 times or less the area of the largest rectangular face of the rectangular cuboid with the minimum possible volume which contains the component.[1883]The method according to any of [1] to [1882], wherein the significant cross-section of the component is 0.009 times or less the area of the largest rectangular face of the rectangular cuboid with the minimum possible volume which contains the component.[1884]The method according to any of [1] to [1883], wherein the significant cross-section of the component is 0.0009 times or less the area of the largest rectangular face of the rectangular cuboid with the minimum possible volume which contains the component.[1885]The method according to any of [1] to [1884], wherein the significant cross-section of the component is 0.0002 times or less the area of the largest rectangular face of the rectangular cuboid with the minimum possible volume which contains the component.[1886]The method according to any of [1] to [1885], wherein the significant cross-section of the component is less than 49% of the area of the largest rectangular face of the rectangular cuboid with the minimum possible volume which contains the component,[1887]The method according to any of [1] to [1886], wherein the significant cross-section of the component is less than 19% of the area of the largest rectangular face of the rectangular cuboid with the minimum possible volume which contains the component.[1888]The method according to any of [1] to [1887], wherein the significant cross-section of the component is less than 9% of the area of the largest rectangular face of the rectangular cuboid with the minimum possible volume which contains the component.[1889]The method according to any of [1] to [1888], wherein the significant cross-section of the component is less than 4% of the area of the largest rectangular face of the rectangular cuboid with the minimum possible volume which contains the component.[1890]The method according to any of [1] to [1889], wherein the significant cross-section of the component is less than 1.9% of the area of the largest rectangular face of the rectangular cuboid with the minimum possible volume which contains the component.[1891]The method according to any of [1] to [1890], wherein the significant cross-section of the component is less than 0.9% of the area of the largest rectangular face of the rectangular cuboid with the minimum possible volume which contains the component. [1892]The method according to any of [1] to [1891], wherein the significant cross-section of the component is less than 0.09% of the area of the largest rectangular face of the rectangular cuboid with the minimum possible volume which contains the component.[1893]The method according to any of [1] to [1892], wherein the significant cross-section is the largest cross-section of the component.[1894]The method according to any of [1] to [1893], wherein the significant cross-section is the mean cross-section of the component.[1895]The method according to any of [1] to [1894], wherein the significant cross-section of the component is the mean cross-section obtained when the 20% of the largest cross-sections and the 20% of the smallest cross-sections are not considered to calculate the mean cross-section.[1896]The method according to any of [1] to [1895], wherein the significant cross-section of the component is the largest cross-section obtained after excluding the 10% of the largest cross-sections.[1897]The method according to any of [1] to [1896], wherein the significant cross-section of the component is the largest cross-section obtained after excluding the 15% of the largest cross-sections.[1898]The method according to any of [1] to [1897], wherein the significant cross-section of the component is the largest cross-section obtained after excluding the 20% of the largest cross-sections.[1899]The method according to any of [1] to [1898], wherein the significant cross-section of the component is the largest cross-section obtained after excluding the 30% of the largest cross-sections.[1900]The method according to any of [1] to [1899], wherein the significant cross-section of the component is the largest cross-section obtained after excluding the 40% of the largest cross-sections.[1901]The method according to any of [1] to [1900], wherein the significant cross-section of the component is the largest cross-section obtained after excluding the 50% of the largest cross-sections.[1902]The method according to any of [1] to [1901], wherein a cross-section is significant, when at least 20% of the cross-sections are within the range.[1903]The method according to any of [1] to [1902], wherein a cross-section is significant, when at least 30% of the cross-sections are within the range. [1904]The method according to any of [1] to [1903], wherein the cross-sections of the component are each of the minimum cross-sections of the component calculated from each cubic voxel with an edge length of 0.01 mm which is totally comprised in the component, provided that the minimum cross-section of the component associated to each cubic voxel is the minimum cross-section of the component which comprises the geometrical center of the cubic voxel and that there is at least one cubic voxel having a geometrical center which is coincident with the gravity center, considering homogeneous density, of the rectangular cuboid and that the faces of the cubic voxels and the faces of the rectangular cuboid are parallel.[1905] The method according to any of [1] to [1904], wherein the cross-sections of the component are each of the minimum cross-sections of the component calculated from each cubic voxel with an edge length of 0.04 mm which is totally comprised in the component, provided that the minimum cross-section of the component associated to each cubic voxel is the minimum cross-section of the component which comprises the geometrical center of the cubic voxel and that there is at least one cubic voxel having a geometrical center which is coincident with the geometrical center, considering homogeneous density, of the rectangular cuboid and that the faces of the cubic voxels and the faces of the rectangular cuboid are parallel.[1906]The method according to any of [1] to [1905], wherein the cross-sections of the component are each of the minimum cross-sections of the component calculated from each rectangular cubic voxel which is totally comprised in the component, wherein the number of rectangular cuboid voxels comprised in the component is calculated from Vrc=V/n³ being Vrc the volume of the rectangular cubic voxels in m³, V is the volume of the rectangular cuboid in m³ and n³ is the number of rectangular cuboid voxels which are contained in the rectangular cuboid, being n a natural number which is more than 11 and less than 990000, provided that the minimum cross-section of the component associated to each rectangular cubic voxel is the minimum cross-section of the component which comprises the geometrical center of the rectangular cuboid voxel.[1907]The method according to any of [1] to [1906], wherein the cross-sections of the component are each of the minimum cross-sections of the component calculated from each rectangular cubic voxel which is totally comprised in the component, wherein the number of rectangular cuboid voxels comprised in the component is calculated from Vrc=V/n³ being Vrc the volume of the rectangular cubic voxels in m, V is the volume of the rectangular cuboid in m³ and n³ is the number of rectangular cuboid voxels which are contained in the rectangular cuboid, being n a natural number which is more than 11 and less than 94000, provided that the minimum cross-section of the component associated to each rectangular cubic voxel is the minimum cross-section of the component which comprises the geometrical center of the rectangular cuboid voxel.[1908]The method according to any of [1] to [1907], wherein the cross-sections of the component are each of the minimum cross-sections of the component calculated from each rectangular cubic voxel which is totally comprised in the component, wherein the number of rectangular cuboid voxels comprised in the component is calculated from Vrc-V/n³ being Vrc the volume of the rectangular cubic voxels in m³, V is the volume of the rectangular cuboid in m³ and n³ is the number of rectangular cuboid voxels which are contained in the rectangular cuboid, being n=41000, provided that the minimum cross-section of the component associated to each rectangular cubic voxel is the minimum cross-section of the component which comprises the geometrical center of the rectangular cuboid voxel.[1909]The method according to any of [1] to [1908], wherein the mean cross-section of the component is more than 0.2 mm² and 0.79 times or less the area of the largest rectangular face of the rectangular cuboid with the minimum possible volume which contains the component.[1910]The method according to any of [1] to [1909], wherein the mean cross-section of the component is more than 0.2 mm² and 0.69 times or less the area of the largest rectangular face of the rectangular cuboid with the minimum possible volume which contains the component.[1911]The method according to any of [1] to [1910], wherein the mean cross-section of the component is more than 0.2 mm^{a} and less than 49% of the area of the largest rectangular face of the rectangular cuboid with the minimum possible volume which contains the component.[1912]The method according to any of [1] to [1911], wherein the mean cross-section of the component is more than 0.2 mm² and less than 19% of the area of the largest rectangular face of the rectangular cuboid with the minimum possible volume which contains the component.[1913]The method according to any of [1] to [1912], wherein the largest cross-section of the component is more than 0.2 mm² and less than 49% of the area of the largest rectangular face of the rectangular cuboid with the minimum possible volume which contains the component and is the largest cross-section obtained after excluding the 40% of the largest cross-sections of the component, wherein the cross-sections of the component are each of the minimum cross-sections of the component calculated from each cubic voxel with an edge length of 0.04 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel.[1914]The method according to any of [1] to [1913], wherein the largest cross-section of the component is more than 2 mm² and less than 49% of the area of the largest rectangular face of the rectangular cuboid with the minimum possible volume which contains the component and is the largest cross-section obtained after excluding the 50% of the largest cross-sections of the component, wherein the cross-sections of the component are each of the minimum cross-sections of the component calculated from each cubic voxel with an edge length of 0.04 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel,[1915]The method according to any of [1] to [1914], wherein the significant thickness of the component is more than 0.12 mm and less than 1900 mm.[1916]The method according to any of [1] to [1915], wherein the significant thickness of the component is more than 0.12 mm and less than 580 mm.[1917]The method according to any of [1] to [1916], wherein the significant thickness of the component is more than 0.12 mm.[1918]The method according to any of [1] to [1917], wherein the significant thickness of the component is more than 1.2 mm.[1919]The method according to any of [1] to [1918], wherein the significant thickness of the component is more than 12 mm.[1920]The method according to any of [1] to [1919], wherein the significant thickness of the component is more than 22 mm.[1921]The method according to any of [1] to [1920], wherein the significant thickness of the component is more than 112 mm.[1922]The method according to any of [1] to [1921], wherein the significant thickness of the component is less than 1900 mm.[1923]The method according to any of [1] to [1922], wherein the significant thickness of the component is less than 900 mm.[1924]The method according to any of [1] to [1923], wherein the significant thickness of the component is less than 580 mm.[1925]The method according to any of [1] to [1924], wherein the significant thickness of the component is less than 380 mm.[1926]The method according to any of [1] to [1925], wherein the significant thickness of the component is less than 180 mm.[1927]The method according to any of [1] to [1926], wherein the significant thickness of the component is less than 80 mm.[1928]The method according to any of [1] to [1927], wherein the significant thickness of the component is less than 40 mm.[1929]The method according to any of [1] to [1928], wherein the significant thickness of the component is less than 19 mm.[1930]The method according to any of [1] to [1929], wherein the significant thickness of the component is less than 9 mm.[1931]The method according to any of [1] to [1930], wherein the significant thickness of the component is less than 0.9 mm.[1932]The method according to any of [1] to [1931], wherein the significant thickness is the square root of the minimum cross-section of the component, being the cross-sections of the component each of the minimum cross-sections of the component calculated from each cubic voxel with an edge length of 0.01 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel. [1933]The method according to any of [1] to [1932], wherein the significant thickness is the square root of the minimum cross-section of the component, being the cross-sections of the component each of the minimum cross-sections of the component calculated from each cubic voxel with an edge length of 0.04 mm which is totally comprised in the component, provided that the minimum cross-section of the component associated to each cubic voxel is the minimum cross-section of the component which comprises the geometrical center of the cubic voxel and that there is at least one cubic voxel having a gravity center which is coincident with the geometrical center of the rectangular cuboid and that the faces of the cubic voxels and the faces of the rectangular cuboid are parallel.[1934]The method according to any of [1] to [1933], wherein the significant thickness is the square root of the minimum cross-section of the component, being the cross-sections of the component each of the minimum cross-sections of the component calculated from each rectangular cubic voxel which is totally comprised in the component, wherein the number of rectangular cuboid voxels comprised in the component is calculated from Vrc=V/n³ being Vrc the volume of the rectangular cubic voxels in m³, V is the volume of the rectangular cuboid in m³ and n³ is the number of rectangular cuboid voxels which are contained in the rectangular cuboid, being n=41000, provided that the minimum cross-section of the component associated to each rectangular cubic voxel is the minimum cross-section of the component which comprises the geometrical center of the rectangular cuboid voxel.[1935]The method according to any of [1] to [1934], wherein the significant thickness is the square root of the minimum cross-section of the component, being the cross-sections of the component each of the minimum cross-sections of the component calculated from each rectangular cubic voxel which is totally comprised in the component, wherein the number of rectangular cuboid voxels comprised in the component is calculated from Vrc=V/n³ being Vrc the volume of the rectangular cubic voxels in m³, V is the volume of the rectangular cuboid in m³ and n³ is the number of rectangular cuboid voxels which are contained in the rectangular cuboid, being n=41000, provided that the minimum cross-section of the component associated to each rectangular cubic voxel is the minimum cross-section of the component which comprises the gravity center of the rectangular cuboid voxel.[1936]The method according to any of [1] to [1935], wherein the significant thickness is the largest thickness of the component.[1937]The method according to any of [1] to [1936], wherein the significant thickness is the mean thickness of the component. [1938]The method according to any of [1] to [1937], wherein the significant thickness of the component is the largest thickness obtained after excluding the 10% of the largest thickness.[1939]The method according to any of [1] to [1938], wherein the significant thickness of the component is the largest thickness obtained after excluding the 20% of the largest thickness.[1940]The method according to any of [1] to [1939], wherein the significant thickness of the component is the largest thickness obtained after excluding the 30% of the largest thickness.[1941]The method according to any of [1] to [1940], wherein the significant thickness of the component is the largest thickness obtained after excluding the 40% of the largest thickness.[1942]The method according to any of [1] to [1941], wherein the significant thickness of the component is the largest thickness obtained after excluding the 50% of the largest thickness.[1943]The method according to any of [1] to [1942], wherein a thickness is significant, when at least 20% of the thickness are within the range.[1944]The method according to any of [1] to [1943], wherein a thickness is significant, when at least 40% of the thickness are within the range.[1945]The method according to any of [1] to [1944], wherein the component is the manufactured component.[1946]The method according to any of [1] to [1945], wherein the mechanical strength of the component is higher than 730 MPa.[1947]The method according to any of [1] to [1946], wherein the mechanical strength of the component is higher than 1055 MPa.[1948]The method according to any of [1] to [1947], wherein the mechanical strength of the component is higher than 1355 MPa.[1949]The method according to any of [1] to [1948], wherein the mechanical strength is measured at room temperature.[1950]The method according to any of [1] to [1949], wherein the mechanical strength is measured according to ASTM E8/E89M-16a.[1951]The method according to any of [1] to [1950], wherein the component has a toughness higher than 11 J CVN.[1952]The method according to any of [1] to [1951], wherein the component has a toughness higher than 16 J CVN.[1953]The method according to any of [1] to [1952], wherein the component has a toughness higher than 26 J CVN.[1954]The method according to any of [1] to [1953], wherein the component has a CVN higher than 11 Joule within at least 20 mm from the surface of the component.[1955]The method according to any of [1] to [1954], wherein the component has a CVN higher than 16 Joule within at least 20 mm from the surface of the component.[1956]The method according to any of [1] to [1955], wherein the component has a CVN higher than 26 Joule within at least 20 mm from the surface of the component.[1957]The method according to any of [1] to [1956], wherein the component has an elongation above 4%.[1958]The method according to any of [1] to [1957], wherein the component has an elongation above 10.1%.[1959]The method according to any of [1] to [1958], wherein the component has an elongation above 21%.[1960]The method according to any of [1] to [1959], wherein the elongation is measured at room temperature.[1961]The method according to any of [1] to [1960], wherein the elongation is the elongation at break.[1962]The method according to any of [1] to [1961], wherein the elongation is measured according to ASTM E8/8M-16a.[1963]The method according to any of the preceding claims, wherein the component is a tool.[1964]The method according to any of the preceding claims, wherein the component is a die.[1965]The method according to any of the preceding claims, wherein the component is a die casting die.[1966]The method according to any of the preceding claims, wherein the component is a plastic injection mold.[1967]The method according to any of the preceding claims, wherein the component is a hot stamping die.[1968]The method according to any of the preceding claims, wherein the component is a extrusion die.[1969]The method according to any of the preceding claims, wherein the component is a cold work die.[1970]The method according to any of the preceding claims, wherein the component is a drawing and/or bending die.[1971]The method according to any of the preceding claims, wherein the component is a sheet forming die.[1972]The method according to any of the preceding claims, wherein the component is a cutting die.[1973]The method according to any of the preceding claims, wherein the component is a fiber drawn composite die.[1974]The method according to any of the preceding claims, wherein the component is a composite forming die.[1975]The method according to any of the preceding claims, wherein the component is a die to conform CFRP.[1976]The method according to any of [1] to [1975], wherein % REE is a lanthanide element. [1977]The method according to any of [1] to [1976], wherein % REE is an actinide element.[1978] The method according to any of [1] to [1977], wherein % REE is the sum of % La+% Ce+% Pr+% Nd+% Pm+% Sm+% Eu+% Gd+% Tb+% Dy+% Ho+% Er+% Tm+% Yb+% Lu.[1979]The method according to any of [1] to [1978], wherein % REE is the sum of % Ac+% Th+% Pa+% U+% Np+% Pu+% Am+% Cm+% Bk+% Cf+% Es+% Fm+% Md+% No+% Lr.[1980]The method according to any of [1] to [1979], wherein % REE is the sum of lanthanide and actinide elements.[1981] The method according to any of [1] to [1980], wherein % REE is % La,[1982]The method according to any of [1] to [1981], wherein % REE is % Ac.[1983]The method according to any of [1] to [1982], wherein % REE is % Ce.[1984]The method according to any of [1] to [1983], wherein % REE is % Nd.[1985]The method according to any of [1] to [1984], wherein % REE is % Gd.[1986]The method according to any of [1] to [1985], wherein % REE is % Sm.[1987]The method according to any of [1] to [1986], wherein % REE is % Pr. The method according to any of [1] to [1987], wherein % REE is % Pm.[1989]The method according to any of [1] to [1988], wherein % REE is % Eu.[1990]The method according to any of [1] to [1989], wherein % REE is % Tb.[1991]The method according to any of [1] to [1990], wherein % REE is % Dy.[1992]The method according to any of [1] to [1991], wherein % REE is % Ho.[1993]The method according to any of [1] to [1992], wherein % REE is % Er,[1994]The method according to any of [1] to [1993], wherein % REE is % Tm.[1995]The method according to any of [1] to [1994], wherein % REE is % Yb.[1996]The method according to any of [1] to [1995], wherein % REE is % Lu.[1997]The method according to any of [1] to [1996], wherein % REE is replaced partially or totally by % Cs.[1998]The method according to any of [1] to [1997], wherein the debinding step is mandatory.[1999]The method according to any of [1] to [1998], wherein the fixing step is mandatory.[2000]The method according to any of [1] to [1999], wherein the debinding step is performed after the forming step.[2001]The method according to any of [1] to [2000], wherein the fixing step is performed after the debinding step.[2002]The method according to any of [1] to [2001], wherein the fixing step is performed after the forming step.[2003]The method according to any of [1] to [2002], wherein the debinding step and the fixing step are performed simultaneously and/or in the same furnace or pressure vessel.[2004]The method according to any of [1] to [2003], wherein the debinding step, the fixing step and the consolidation step are performed simultaneously and/or in the same furnace or pressure vessel.[2005]The method according to any of [1] to [2004], wherein the fixing step and the consolidation step are performed simultaneously and/or in the same furnace or pressure vessel.[2006]The method according to any of [1] to [2005], wherein the debinding step, the fixing step, the consolidation step and the densification step are performed simultaneously and/or in the same furnace or pressure vessel.[2007]The method according to any of [1] to [2006], wherein the fixing step, the consolidation step and the densification step are performed simultaneously and/or in the same furnace or pressure vessel.[2008]The method according to any of [1] to [2007], wherein the consolidation step and the densification step are performed simultaneously and/or in the same furnace or pressure vessel.[2009] The method according to any of [1] to [2008], wherein the debinding step and the fixing step are performed simultaneously.[2010] The method according to any of [1] to [2009], wherein the debinding step, the fixing step and the consolidation step are performed simultaneously.[2011]The method according to any of [1] to [2010], wherein the fixing step and the consolidation step are performed simultaneously.[2012]The method according to any of [1] to [2011], wherein the debinding step, the fixing step, the consolidation step and the densification step are performed simultaneously.[2013]The method according to any of [1] to [2012], wherein the fixing step, the consolidation step and the densification step are performed simultaneously,[2014]The method according to any of [1] to [2013], wherein the consolidation step and the densification step are performed simultaneously.[2015]The method according to any of [1] to [2014], wherein the area of the largest rectangular face of the rectangular cuboid is the largest value among a*b, a*c and b*c, being a, b and c the dimensions of the rectangular cuboid with the minimum possible volume which contains the component.[2016]The method according to any of [1] to [2015], wherein the rectangular cuboid with the minimum possible volume which contains the component is the smallest rectangular cuboid containing the component.[2017]The method according to any of [1] to [2016], wherein Tm is the melting temperature of the metallic powder with the lowest melting point in the powder mixture.[2018]The method according to any of [1] to [2017], wherein Tm is the melting temperature of the metallic powder with the lowest melting point in the powder mixture which is at least 0.6 wt % of the powder mixture.[2019]The method according to any of [1] to [2018], wherein Tm is the melting temperature of the metallic powder with the lowest melting point in the powder mixture which is at least 2.6 wt % of the powder mixture.[2020]The method according to any of [1] to [2019], wherein Tm is the melting temperature of the metallic powder with the lowest melting point in the powder mixture which is at least 0.6 vol % of the powder mixture.[2021]The method according to any of [1] to [2020], wherein Tm is the melting temperature of the metallic powder with the lowest melting point in the powder mixture which is at least 2.6 vol % of the powder mixture.[2022]The method according to any of [1] to [2021], wherein Tm is the melting temperature of the metallic powder with the highest melting point in the powder mixture.[2023]The method according to any of [1] to [2022], wherein Tm is the melting temperature of the metallic powder with the highest melting point in the powder mixture which is at least 0.6 wt % of the powder mixture.[2024]The method according to any of [1] to [2023], wherein Tm is the melting temperature of the metallic powder with the highest melting point in the powder mixture which is at least 2.6 wt % of the powder mixture.[2025]The method according to any of [1] to [2024], wherein Tm is the melting temperature of the metallic powder with the highest melting point in the powder mixture which is at least 0.6 vol % of the powder mixture.[2026]The method according to any of [1] to [2025], wherein Tm is the melting temperature of the metallic powder with the highest melting point in the powder mixture which is at least 2.6 vol % of the powder mixture.[2027]The method according to any of [1] to [2026], wherein Tm is the mean melting temperature (volume-weighted arithmetic mean, where the weights are the volume fractions) of the powder mixture.[2028]The method according to any of [1] to [2027], wherein Tm is the mean melting temperature (mass-weighted arithmetic mean, where the weights are the weight fractions) of the powder mixture.[2029]The method according to any of [1] to [2028], wherein Tm is the melting temperature of the metallic powder.[2030]The method according to any of [1] to [2029], wherein the melting temperature is measured by thermal analysis.[2031]The method according to any of [1] to [2030], wherein the melting temperature is measured according to ASTM E794-06(2012).[2032]The method according to any of [1] to [2031], wherein the carbon potential of the furnace or pressure vessel atmosphere is determined by simulation using ThermoCalc (version 2020b).[2033]The method according to any of [1] to [2032], wherein the carbon potential of the component surface is determined by simulation using ThermoCalc (version 2020b).[2034]The method according to any of [1] to [2033], wherein Kn is calculated as pNH₃/pH₂^{3/2}, being pNH₃ the partial pressure of NH₃ in bar and pH₂ the partial pressure of H₂ in bar.[2035]The method according to any of [1] to [2034], wherein the nitriding potential, kn, is measured according to DIN 17 022-4.[2036]The method according to any of [1] to [2035], wherein the nitriding potential, kn, is measured according to SAE AMS 2759/10 B.[2037]The method according to any of [1] to [2036], wherein D50 is measured by laser diffraction,[2038]The method according to any of [1] to [2037], wherein D50 is measured according to ISO 13320-2009.[2039]The method according to any of [1] to [2038], wherein the % NMVS in the metallic part of the component=(volume of NMVS/volume of NMVT)*100.[2040]The method according to any of [1] to [2039], wherein the volume of NMVS is the volume of non-metallic voids located inside the metallic part of the component with direct access to the surface of the component without crossing a metal part, being the volume in m³.[2041]The method according to any of [1] to [2040], wherein the volume of NMVS is the volume of voids located inside the metallic part of the component with direct access to the surface of the component without crossing a metal part, being the volume in m³.[2042]The method according to any of [1] to [2041], wherein the volume of NMVS is the volume of porosities located inside the metallic part of the component with direct access to the surface of the component, being the volume in m³.[2043]The method according to any of [1] to [2042], wherein the volume of NMVT is the total volume of non-metallic voids in the component, being the volume in m³.[2044]The method according to any of [1] to [2043], wherein the volume of NMVT is the total volume of voids in the component, being the volume in m³.[2045]The method according to any of [1] to [2044], wherein the volume of NMVT is the total volume of porosities in the component, being the volume in m³.[2046]The method according to any of [1] to [2045], wherein the % NMVC in the metallic part of the component=(volume of NMVS/total volume of the component)*100.[2047]The method according to any of [1] to [2046], wherein the volume of NMVS is measured according to Pure & Appl. Chern., Vol. 66, No. 8, pp. 1739-1758, 1994. [2048]The method according to any of [1] to [2047], wherein the volume of NMVT is measured according to Pure & Appl. Chern., Vol. 66, No. 8, pp. 1739-1758, 1994. [2049]The method according to any of [1] to [2048], wherein the volume of NMVT is measured by stereology.[2050]The method according to any of [1] to [2049], wherein the volume of NMVS is measured by stereology.[2051] The method according to any of [1] to [2050], wherein the percentage of reduction of NMVS in the metallic part of the component after the consolidation step=[(total % NMVT in the component after the consolidation step*% NMVS of the component after the consolidation step)/(total % NMVT of the component after the forming step*% NMVS of the component after the forming step)]*100, wherein the total % NMVT of the component=100%-apparent density (in %).[2052]The method according to any of [1] to [2051], wherein the percentage of reduction of NMVS in the metallic part of the component after the consolidation step=[(total % NMVT in the component after the consolidation step*% NMVS in the component after the consolidation step)/(total % NMVT in the component after the debinding step % NMVS in the component after the debinding step)]*100, wherein the total % NMVT of the component=100%-apparent density (in %).[2053]The method according to any of [1] to [2052], wherein the percentage of reduction of NMVS in the metallic part of the component after the densification step=[(total % NMVT in the component after the densification step*% NMVS in the component after the densification step)/(total % NMVT in the component after the forming step*% NMVS in the component after the forming step)]*100, wherein the total % NMVT in the component=100%-apparent density (in %).[2054]The method according to any of [1] to [2053], wherein the percentage of reduction of NMVS in the metallic part of the component after the densification step=[(total % NMVT in the component after the densification step *% NMVS in the component after the densification step)/(total % NMVT in the component after the debinding step % NMVS in the component after the debinding step)]*100, wherein the total % NMVT in the component=100%-apparent density (%), wherein the total % NMVT of the component=100%-apparent density (in %).[2055]The method according to any of [1] to [2054], wherein the percentage of reduction of NMVC in the metallic part of the component after the densification step=[(total % NMVT in the component after the densification step*% NMVC in the component after the densification step)/(total % NMVT in the component after the forming step*% NMVC in the component after the forming step)]*100, wherein the total % NMVT in the component=100%-apparent density (in %).[2056]The method according to any of [1] to [2055], wherein the percentage of reduction of NMVC in the metallic part of the component after the densification step=[(total % NMVT in the component after the densification step*% NMVC in the component after the densification step)/(total % NMVT in the component after the debinding step*% NMVC in the component after the debinding step)]*100, wherein the total % NMVT of the component=100%-apparent density (in %).[2057]The method according to any of [1] to [2056], wherein the percentage of reduction of NMVS in the metallic part of the component after the consolidation step=[(total % NMVT in the metallic part of the component after the consolidation step*% NMVS in the metallic part of the component after the consolidation step)/(total % NMVT in the metallic part of the component after the forming step*% NMVS in the metallic part of the component after the forming step)]*100, wherein the total % NMVT in the metallic part of the component=100%-apparent density (in %).[2058]The method according to any of [1] to [2057], wherein the percentage of reduction of NMVS in the metallic part of the component after the consolidation step=[(total % NMVT in the metallic part of the component after the consolidation step*% NMVS in the metallic part of the component after the consolidation step)/(total % NMVT in the metallic part of the component after the debinding step % NMVS in the metallic part of the component after the debinding step)]*100, wherein the total % NMVT of the component=100%-apparent density (in %).[2059]The method according to any of [1] to [2058], wherein the percentage of reduction of NMVS in the metallic part of the component after the densification step=[(total % NMVT in the metallic part of the component after the densification step*% NMVS in the metallic part of the component after the densification step)/(total % NMVT in the metallic part of the component after the forming step*% NMVS in the metallic part of the component after the forming step)]*100, wherein the total % NMVT in the metallic part of the component=100%-apparent density (in %).[2060]The method according to any of [1] to [2059], wherein the percentage of reduction of NMVS in the metallic part of the component after the densification step=[(total % NMVT in the metallic part of the component after the densification step *% NMVS in the metallic part of the component after the densification step)/(total % NMVT in the metallic part of the component after the debinding step*% NMVS in the metallic part of the component after the debinding step)]*100, wherein the total % NMVT in the metallic part of the component=100%-apparent density (%), wherein the total % NMVT of the component=100%-apparent density (in %).[2061]The method according to any of [1] to [2060], wherein the percentage of reduction of NMVC in the metallic part of the component after the densification step=[(total % NMVT in the metallic part of the component after the densification step*% NMVC in the metallic part of the component after the densification step)/(total % NMVT in the metallic part of the component after the forming step*% NMVC in the metallic part of the component after the forming step)]*100, wherein the total % NMVT in the metallic part of the component=100%-apparent density (in %).[2062]The method according to any of [1] to [2061], wherein the percentage of reduction of NMVC in the metallic part of the component after the densification step=[(total % NMVT in the metallic part of the component after the densification step *% NMVC in the metallic part of the component after the densification step)/(total % NMVT in the metallic part of the component after the debinding step*% NMVC in the metallic part of the component after the debinding step)]*100, wherein the total % NMVT of the component=100%-apparent density (in %).[2063]The method according to any of [1] to [2062], wherein the voids having a volume which is above the volume of the component*10⁻² are not considered to calculate the volume of voids.[2064]The method according to any of [1] to [2063], wherein the volume of NMVT is the total volume of voids in the component in m³.[2065]The method according to any of [1] to [2064], wherein ceramics are excluded to calculate the volume of voids.[2066]The method according to any of [1] to [2065], wherein, intermetallics are excluded to calculate the volume of voids.[2067]The method according to any of [1] to [2066], wherein the geometrical aspects which are part of the design of the component, are not considered to calculate the volume of voids.[2068]The method according to any of [1] to [2067], wherein the voids having a volume which is above the volume of the component*10⁻² are not considered to calculate the volume of voids.[2069]The method according to any of [1] to [2068], wherein the voids having a volume which is above the volume of the component*10⁻³ are not considered to calculate the volume of voids.[2070]The method according to any of [1] to [2069], wherein the voids having a volume which is above the volume of the component*10⁻⁴ are not considered to calculate the volume of voids.[2071]The method according to any of [1] to [2070], wherein the voids having a volume which is above the volume of the component*10⁻⁵ are not considered to calculate the volume of voids.[2072]The method according to any of [1] to [2071], wherein the voids having a volume which is above the volume of the component*10⁻⁶ are not considered to calculate the volume of voids.[2073]The method according to any of [1] to [2072], wherein the voids comprise porosity.[2074]The method according to any of [1] to [2073], wherein the voids comprise only porosity.[2075]The method according to any of [1] to [2074], wherein the percentage of increase of the apparent density of the metallic part of the component after the consolidation step the absolute value of [(apparent density of the component after the consolidation step —apparent density of the component after the forming step)/apparent density of the component after the consolidation step]*100.[2076]The method according to any of [1] to [2075], wherein the percentage of increase of the apparent density of the metallic part of the component after the consolidation step=the absolute value of [(apparent density after the consolidation step —apparent density after the debinding/apparent density after the consolidation step]*100.[2077]The method according to any of [1] to [2076], wherein the percentage of increase of the apparent density of the metallic part of the component after the densification step=the absolute value of [(apparent density of the component after the densification step —apparent density of the component after the forming step)/apparent density of the component after the densification step]*100.[2078] The method according to any of [1] to [2077], wherein the percentage of increase of the apparent density of the metallic part of the component after the densification step=the absolute value of [(apparent density after the densification step —apparent density after the debinding/apparent density after the densification step]*100.[2079]The method according to any of [1] to [2078], wherein the apparent density=(real density/theoretical density)*100.[2080] The method according to any of [1] to [2079], wherein the real density of the component is measured by the Archimedes' Principe. [2081]The method according to any of [1] to [2080], wherein the real density of the component is measured according to ASTM B962-08.[2082]The method according to any of [1] to [2081], wherein the density values are at 20° C. and 1 atm.[2083]The method according to any of [1] to [2082], wherein the volume of the component is measured by the Archimedes' Principe.[2084]The method according to any of [1] to [2083], wherein “in the metallic part of the component” is replaced by “in the inorganic part of the component”, when reference is made to the % NMVS, the percentage of reduction of NMVS, the % NMVC, the percentage of reduction of NMVC, the apparent density or the percentage of increase of the apparent density.[2085]The method according to any of [1] to [2084], wherein “in the metallic part of the component” is replaced by “in the inorganic part of the component”.[2086]The method according to any of [1] to [2085], wherein “component” is replaced by “at least part of the component”, when reference is made to the % NMVS, the percentage of reduction of NMVS, the % NMVC, the percentage of reduction of NMVC, the apparent density or the percentage of increase of the apparent density.[2087]The method according to any of [1] to [2086], wherein “component” is replaced by “at least part of the component”.[2088]The method according to any of [1] to [2087], wherein “in the metallic part of the component” is replaced by “at least in a material comprised in the component”, when reference is made to the % NMVS, the percentage of reduction of NMVS, the % NMVC, the percentage of reduction of NMVC, the apparent density or the percentage of increase of the apparent density. The method according to any of [1] to [2088], wherein “in the metallic part of the component” is replaced by “at least in a material comprised in the component”.[2090]The method according to any of [1] to [2089], wherein “polymer and/or binder” is replaced by “organic material”.[2091]The method according to any of [1] to [2090], wherein the organic material is a polymer and/or binder.[2092]The method according to any of [1] to [2091], wherein the organic material is a polymer.[2093]The method according to any of [1] to [2092], wherein the organic material is a binder.[2094]The method according to any of [1] to [2093].[2095]A component manufactured according to any of [1] to [2094],[2096]A component comprising main channels.[2097]A component comprising one main channel.[2098]The component according to any of [1] to [2097], comprising at least 2 and less than 39 main channels.[2099]The component according to any of [1] to [2098], at least 4 main channels.[2100]The component according to any of [1] to [2099], at least 11 main channels.[2101]The component according to any of [1] to [2100], less than 29 main channels.[2102]The component according to any of [1] to [2101], less than 19 main channels.[2103]The component according to any of [1] to [2102], less than 9 main channels.[2104]The component according to any of [1] to [2103], wherein the main channels are the inlet channels.[2105]The component according to any of [1] to [2104], wherein the main channels are the outlet channels.[2106]The component according to any of [1] to [2105], wherein the entrance and the exit of the fluid is made through different channels which are located inside the component.[2107]The component according to any of [1] to [2106], wherein the profile of the main channels is squared with rounded edges.[2108]The component according to any of [1] to [2107], wherein the profile of the main channels is cylindrical.[2109]The component according to any of [1] to [2108], wherein the profile of the main channels is an inverse droplet.[2110]The component according to any of [1] to [2109], wherein the profile of the main channels is elliptical.[2111]The component according to any of [1] to [2110], wherein the channels are thermo-regulatory channels.[2112]The component according to any of [1] to [2111], wherein the diameter of the main channels is between 3.8 mm and 348 mm.[2113]The component according to any of [1] to [2112], wherein the diameter of the main channels is 11 mm or more.[2114]The component according to any of [1] to [2113], wherein the diameter of the main channels is 294 mm or less.[2115]The component according to any of [1] to [2114], wherein the diameter of the main channels is 57 mm or less.[2116]The component according to any of [1] to [2115], wherein the diameter the diameter is the mean diameter.[2117]The component according to any of [1] to [2116], wherein the diameter the diameter is the equivalent diameter.[2118]The component according to any of [1] to [2117], wherein the diameter the equivalent diameter is the diameter of a circle of equivalent area.[2119]The component according to any of [1] to [2118], wherein the component comprises fine channels.[2120]The component according to any of [1] to [2119], wherein the profile of the fine channels is squared with rounded edges.[2121]The component according to any of [1] to [2120], wherein the profile of the fine channels is cylindrical.[2122]The component according to any of [1] to [2121], wherein the profile of the fine channels is an inverse droplet.[2123]The component according to any of [1] to [2122], wherein the profile of the fine channels is elliptical.[2124]The component according to any of [1] to [2123], wherein the cross-section of the inlet channels is at least 3 times higher than the cross-section of the smallest channel among all the fine channels in the component area where the thermo-regulation is desired.[2125]The component according to any of [1] to [2124], wherein the cross-section of the inlet channels is at least 6 times higher than the cross-section of the smallest channel among all the fine channels in the component area where the thermo-regulation is desired.[2126]The component according to any of [1] to [2125], wherein the cross-section of the main channels is at least 3 times higher than the cross-section of the smallest channel among all the fine channels.[2127]The component according to any of [1] to [2126], wherein the cross-section of the main channels is at least 6 times higher than the cross-section of the smallest channel among all the fine channels.[2128]The component according to any of [1] to [2127], wherein the cross-section of the main channels is between 9 mm² and 95115 mm².[2129]The component according to any of [1] to [2128], wherein the cross-section of the main channels is 2550 mm² or less.[2130]The component according to any of [1]to [2129], wherein the cross-section of the main channels is 14 mm² or more.[2131]The component according to any of [1] to [2130], wherein the cross-section of the main channels is 126 mm² or more.[2132]The component according to any of [1] to [2131], wherein the cross-section is the mean cross-section.[2133]The component according to any of [1] to [2132], wherein the cross-section is the minimum cross-section.[2134]The component according to any of [1] to [2133], wherein the cross-section is the maximum cross-section.[2135]The component according to any of [1] to [2134], wherein the main channels comprise between 2 and 280 branches.[2136]The component according to any of [1] to [2135], wherein the main channels comprise 3 or more branches.[2137]The component according to any of [1] to [2136], wherein the main channels comprise 88 or less branches.[2138]The component according to any of [1] to [2137], wherein the main channels comprise 18 or less branches.[2139]The component according to any of [1] to [2138], wherein the branches are located at the outlet of the main channels.[2140]The component according to any of [1] to [2139], wherein the component comprises secondary channels.[2141]The component according to any of [1] to [2140], wherein the component comprises tertiary channels.[2142]The component according to any of [1] to [2141], wherein the component comprises quaternary channels.[2143]The component according to any of [1] to [2142], wherein the main channels are connected to secondary channels.[2144]The component according to any of [1] to [2143], wherein the main channels are connected to 2 or more and 280 or less secondary channels.[2145]The component according to any of [1] to [2144], wherein the main channels are connected to 110 or more secondary channels.[2146]The component according to any of [1] to [2145], wherein the main channels are connected to 18 or less secondary channels.[2147]The component according to any of [1] to [2146], wherein the main channels are connected to 88 or less secondary channels.[2148]The component according to any of [1] to [2147], wherein at least one main channel is connected to 2 or more and 280 or less secondary channels.[2149]The component according to any of [1] to [2148], wherein at least one main channel is connected to 18 or less secondary channels.[2150]The component according to any of [1] to [2149], wherein at least one main channel is connected to 88 or less secondary channels.[2151]The component according to any of [1] to [2150], wherein at least one main channel is connected to 110 or more secondary channels.[2152]The component according to any of [1] to [2151], wherein the profile of the secondary channels is squared with rounded edges.[2153]The component according to any of [1] to [2152], wherein the profile of the secondary channels is cylindrical.[2154]The component according to any of [1] to [2153], wherein the profile of the secondary channels is an inverse droplet.[2155]The component according to any of [1] to [2154], wherein the profile of the secondary channels is elliptical.[2156]The component according to any of [1] to [2155], wherein the cross-section of the secondary channels is 0.18 mm² or more and less than 122.3 mm².[2157]The component according to any of [1] to [2156], wherein the cross-section of the secondary channels is 3.8 mm² or more.[2158]The component according to any of [1] to [2157], wherein the cross-section of the secondary channels is less than 82.1 mm².[2159]The component according to any of [1] to [2158], wherein the cross-section of the secondary channels is less than 1.4 times the equivalent diameter.[2160]The component according to any of [1] to [2159], wherein the secondary channels are connected to 2 or more and 4900 or less fine channels.[2161]The component according to any of [1] to [2160], wherein the secondary channels are connected to 4 or more fine channels.[2162]The component according to any of [1] to [2161], wherein the secondary channels are connected to 680 or less fine channels.[2163]The component according to any of [1] to [2162], wherein at least one secondary channel is connected to 2 or more and 4900 or less fine channels.[2164]The component according to any of [1] to [2163], wherein at least one secondary channel is connected to 4 or more fine channels.[2165]The component according to any of [1] to [2164], wherein at least one secondary channel is connected to 680 or less fine channels.[2166]The component according to any of [1] to [2165], wherein the sum of the minimum cross-sections of all the fine channels connected to a secondary channel should be equal to the cross-section of the secondary channel to which are connected.[2167]The component according to any of [1] to [2166], wherein the main channels are directly connected to the fine channels.[2168]The component according to any of [1] to [2167], wherein the component comprises only fine channels.[2169]The component according to any of [1] to [2168], wherein the length of the fine channels is between 0.6 mm and 1.8 m.[2170]The component according to any of [1] to [2169], wherein the length of the fine channels is 450 mm or less.[2171]The component according to any of [1] to [2170], wherein the length of the fine channels is 180 mm or less.[2172]The component according to any of [1] to [2171], wherein the length of the fine channels is 1.2 mm or more.[2173]The component according to any of [1] to [2172], wherein the length of the fine channels is 12 mm or more.[2174]The component according to any of [1] to [2173], wherein the length of the fine channels is 21 mm or more.[2175]The component according to any of [1] to [2174], wherein the length of the fine channels refers to the mean length of the fine channels. [2176]The component according to any of [1] to [2175], wherein the length of the fine channels refers to the length of the fine channels in the section under the active surface where an efficient thermo-regulation is desired.[2177]The component according to any of [1] to [2176], wherein the length of the fine channels refers to the total length of the fine channels. [2178]The component according to any of [1] to [2177], wherein the surface density of fine channels is 12% or more.[2179]The component according to any of [1] to [2178], wherein the surface density of fine channels is 27% or more.[2180]The component according to any of [1] to [2179], wherein the surface density of fine channels is 42% or more.[2181]The component according to any of [1] to [2180], wherein the surface density of fine channels is 57% or less.[2182]The component according to any of [1] to [2181], wherein the surface density of fine channels is 47% or less.[2183]The component according to any of [1] to [2182], wherein the surface density of fine channels is calculated as the surface occupied by the fine channels projection/the total thermo-regulated surface.[2184]The component according to any of [1] to [2183], wherein H is greater than 12 and less than 1098.[2185]The component according to any of [1] to [2184], wherein H is greater than 110.[2186]The component according to any of [1] to [2185], wherein H is less than 900.[2187]The component according to any of [1] to [2186], wherein H is less than 230.[2188]The component according to any of [1] to [2187], wherein H=the total length of the fine channels/the mean length of the fine channels.[2189]The component according to any of [1] to [2188], wherein the total length of the fine channels is the sum of the lengths of all the fine channels.[2190]The component according to any of [1] to [2189], wherein the number of fine channels per square meter of the surface of the component is between 21 and 14000 fine channels per square meter.[2191]The component according to any of [1] to [2190], wherein the number of fine channels per square meter of the surface of the component 1100 fine channels per square meter or more.[2192]The component according to any of [1] to [2191], wherein the number of fine channels per square meter of the surface of the component 46 fine channels per square meter or more.[2193]The component according to any of [1] to [2192], wherein the number of fine channels per square meter of the surface of the component 9000 fine channels per square meter or less.[2194]The component according to any of [1] to [2193], wherein the number of fine channels per square meter of the surface of the component 4000 fine channels per square meter or less.[2195]The component according to any of [1] to [2194], wherein the surface of the component is the surface to be thermo-regulated.[2196]The component according to any of [1] to [2195], wherein the surface of the component is the active surface.[2197]The component according to any of [1] to [2196], wherein the surface of the component is the working surface.[2198]The component according to any of [1] to [2197], wherein the distance of the fine channels to the surface is between 0.6 mm and 32 mm.[2199]The component according to any of [1] to [2198], wherein the distance of the fine channels to the surface is 1.2 mm or more.[2200]The component according to any of [1] to [2199], wherein the distance of the fine channels to the surface is 18 mm or less.[2201]The component according to any of [1] to [2200], wherein the distance of the fine channels to the surface is 8 mm or less.[2202]The component according to any of [1] to [2201], wherein the distance of the fine channels to the surface is the mean distance among all the distances to the surface of every singular fine channel.[2203]The component according to any of [1] to [2202], wherein the distance of the fine channels to the surface is the minimum distance among all the distances to the surface of every singular fine channel.[2204]The component according to any of [1] to [2203], wherein the distance of the fine channels to the surface is the maximum distance among all the distances to the surface of every singular fine channel.[2205]The component according to any of [1] to [2204], wherein the surface refers to the surface area of the component to be thermo-regulated.[2206]The component according to any of [1] to [2205], wherein the distance of a singular fine channel to the surface is the minimum distance of any point in that channel to a point in the surface area to be thermo-regulated.[2207]The component according to any of [1] to [2206], wherein the distance of a singular fine channel to the surface is calculated in the following fashion: for every plane which is simultaneously orthogonal to the surface area to be thermo-regulated and the vector of the maximum speed of the fluid circulating in the fine channel, the minimum distance to the surface to be thermo-regulated of any point in that plane belonging to the fine channel is considered, the mean value of all considered distances is taken.[2208]The component according to any of [1] to [2207], wherein the fine channels are separated from each other a distance between 0.2 mm and 18 mm.[2209]The component according to any of [1] to [2208], wherein the fine channels are separated from each other a distance of 0.9 mm or more.[2210]The component according to any of [1] to [2209], wherein the fine channels are separated from each other a distance of 1.2 mm or more. [2211]The component according to any of [1] to [2210], wherein the fine channels are separated from each other a distance of 9 mm or less.[2212]The component according to any of [1] to [2211], wherein the distance is the mean distance.[2213]The component according to any of [1] to [2212], wherein the distance is the minimum distance.[2214] The component according to any of [1] to [2213], wherein the distance is the maximum distance.[2215]The component according to any of [1] to [2214], wherein the diameter of the fine channels is between 0.1 mm and 128 mm.[2216]The component according to any of [1] to [2215], wherein the diameter of the fine channels is 0.6 mm or more.[2217]The component according to any of [1] to [2216], wherein the diameter of the fine channels is 1.2 mm or more.[2218]The component according to any of [1] to [2217], wherein the diameter of the fine channels is 38 mm or less. [2219]The component according to any of [1] to [2218], wherein the diameter of the fine channels is 8 mm or less.[2220]The component according to any of [1] to [2219], wherein the diameter is the mean diameter.[2221]The component according to any of [1] to [2220], wherein the diameter is the minimum diameter.[2222]The component according to any of [1] to [2221], wherein the diameter is the mean equivalent diameter.[2223]The component according to any of [1] to [2222], wherein the diameter is the mean minimum equivalent diameter.[2224]The component according to any of [1] to [2223], wherein the cross-section of the fine channels is between 0.008 mm² and 12868 mm².[2225]The component according to any of [1] to [2224], wherein the cross-section of the fine channels is 3900 mm² or less 255 mm² or less.[2226]The component according to any of [1] to [2225], wherein the cross-section of the fine channels is 0.28 mm² or more.[2227]The component according to any of [1] to [2226], wherein the cross-section of the fine channels is 1.13 mm² or more.[2228]The component according to any of [1] to [2227], wherein the total pressure drop in the thermo-regulation system is at least 0.01 bar and less than 7.9 bar.[2229]The component according to any of [1] to [2228], wherein the total pressure drop in the thermo-regulation system is at least 0.1 bar.[2230]The component according to any of [1] to [2229], wherein the total pressure drop in the thermo-regulation system is less than 3.8 bar.[2231]The component according to any of [1] to [2230], wherein the pressure drop in the fine channels is at least 0.01 bar and less than 5.9 bar.[2232]The component according to any of [1] to [2231], wherein the pressure drop in the fine channels is less than 2.8 bar.[2233]The component according to any of [1] to [2232], wherein the pressure drop in the fine channels is at least 0.09 bar.[2234]The component according to any of [1] to [2233], wherein the pressure drop in the fine channels is at least 0.2 bar.[2235]The component according to any of [1] to [2234], wherein the rugosity within the channels is at least 0.9 microns and less than 198 microns.[2236]The component according to any of [1] to [2235], wherein the rugosity within the channels is less than 98 microns.[2237]The component according to any of [1] to [2236], wherein the rugosity within the channels is at least 10.2 microns.[2238]The component according to any of [1] to [2237], wherein the fluid flows in the channels in such a way that the Reynolds number is greater than 810 and less than 89000.[2239]The component according to any of [1] to [2238], wherein the fluid flows in the channels in such a way that the Reynolds number is greater than 2800.[2240]The component according to any of [1] to [2239], wherein the fluid flows in the channels in such a way that the Reynolds number is less than 26000.[2241]The component according to any of [1] to [2240], wherein the mean speed of the fluid in the channels is greater than 0.7 m/s and less than 14 m/s.[2242]The component according to any of [1] to [2241], wherein the mean speed of the fluid in the channels is greater than 1.6 m/s.[2243]The component according to any of [1] to [2242], wherein the mean speed of the fluid in the channels is less than 9 m/s.[2244]The component according to any of [1] to [2243], wherein the component comprises at least one inlet collector and one outlet collector connected by more than one fine channel.[2245]The component according to any of [1] to [2244], wherein the component comprises at least one inlet collector and one outlet collector connected by at least 2 and less than 4900 fine channels.[2246]The component according to any of [1] to [2245], wherein the component comprises at least one inlet collector and one outlet collector connected by at least 3 fine channels.[2247]The component according to any of [1] to [2240], wherein the component comprises at least one inlet collector and one outlet collector connected by less than 680 fine channels.[2248]The component according to any of [1] to [2247], wherein the temperature gradient within the collector is below 39° C.[2249]The component according to any of [1] to [2248], wherein the temperature gradient within the collector is below 9° C.[2250]The component according to any of [1] to [2249], wherein the temperature gradient within the collector is below 4° C.[2251]The component according to any of [1] to [2250], wherein the temperature gradient is calculated using the mean temperature corresponding to the insertion section of the fine channels into the main/secondary channels which are part of the collector.[2252]The component according to any of [1] to [2251], wherein the temperature gradient of the collector is calculated with 12% of the insertion sections that lead to a minimum gradient within the collector.[2253]The component according to any of [1] to [2252], wherein the temperature gradient of the collector is calculated with 20% of the insertion sections that lead to a minimum gradient within the collector.[2254]The component according to any of [1] to [2253], wherein the temperature gradient of the collector is calculated with 50% of the insertion sections that lead to a minimum gradient within the collector.[2255]The component according to any of [1] to [2254], wherein the temperature gradient between the two insertion points of the fine channels to the collectors, for the 12% k of the fine channels whose temperature gradients between their two insertion points are greater, is more than 1.1° C. and less than 199° C.[2256]The component according to any of [1] to [2255], wherein the temperature gradient between the two insertion points of the fine channels to the collectors is more than 2.6° C.[2257]The component according to any of [1] to [2256], wherein the temperature gradient between the two insertion points of the fine channels to the collectors is less than 94° C.[2258]The component according to any of [1] to [2257], wherein the temperature gradient between the two insertion points of the fine channels to the collectors is more than 1.1° C. and less than 199° C.[2259]The component according to any of [1] to [2258], wherein the temperature gradient between the two insertion points of the fine channels to the collectors, for the 50% of the fine channels whose temperature gradients between their two insertion points are greater, is more than 2.6° C.[2260]The component according to any of [1] to [2259], wherein the temperature gradient between the two insertion points of the fine channels to the collectors, for the 50% of the fine channels whose temperature gradients between their two insertion points are greater, is less than 94° C.[2261] The component according to any of [1] to [2260], wherein the temperature gradient between the two insertion points of the fine channels to the collectors, for the 12% of the fine channels whose temperature gradients between their two insertion points are greater, is more than 2.6° C.[2262]The component according to any of [1] to [2261], wherein the temperature gradient between the two insertion points of the fine channels to the collectors, for the 12% of the fine channels whose temperature gradients between their two insertion points are greater, is less than 94° C.[2263]The component according to any of [1] to [2262], wherein the component comprises channels that carry a liquid to the surface of the component.[2264]The component according to any of [1] to [2263], wherein the distance of the channels that carry the liquid to the surface of the component is less than 19 mm.[2265]The component according to any of [1] to [2264], wherein the distance of the channels that carry the liquid to the surface of the component is 0.6 mm or more.[2266]The component according to any of [1] to [2265], wherein the diameter of the holes in the surface of the component is between 2 microns and 1 mm.[2267]The component according to any of [1] to [2266], wherein the diameter of the holes in the surface of the component is 12 microns or more.[2268]The component according to any of [1] to [2267], wherein the diameter of the holes in the surface of the component is less than 490 microns.[2269]The component according to any of [1] to [2268], wherein the length of the holes in the surface of the component is 0.1 mm or more and less than 19 mm.[2270]The component according to any of [1] to [2269], wherein the length of the holes in the surface of the component is 0.6 mm or more.[2271]The component according to any of [1] to [2270], wherein the length of the holes in the surface of the component is 9 mm or less.[2272]The component according to any of [1] to [2271], wherein the diameter of the channels that carry the liquid to the surface of the component is 0.6 mm or more and 19 mm or less.[2273]The component according to any of [1] to [2272], wherein the diameter of the channels that carry the liquid to the surface of the component is more than 1.1 mm. [2274]The component according to any of [1] to [2273], wherein the diameter of the channels that carry the liquid to the surface of the component is less than 4 mm.[2275]The component according to any of [1] to [2274], wherein the cross-section is the cross-sectional area.[2276]A component according to any of [1] to [2275]. [2277]A component comprising fine channels with a cross section between 0.008 mm² and 12868 mm² and a mean length between 0.6 mm and 1.8 m with a H value greater than 12 and less than 1098, being H=the total length of the fine channels/the mean length of the fine channels: wherein the equivalent diameter of the fine channels is between 0.1 mm to 128 mm.[2278]A component comprising fine channels with a cross section between 1.13 mm² and 50 mm², and at least one inlet collector and one outlet collector connected by more than one fine channel with a temperature gradient within the collector below 39° C.; wherein the temperature gradient between the two insertion points of the fine channels to the collectors, for the 12% k of the fine channels whose temperature gradients between their two insertion points are greater, is more than 1.1° C.[2279]A component comprising fine channels, wherein the distance from the fine channels to the surface to be thermo-regulated is between 0.6 mm and 32 mm: wherein the equivalent diameter of the fine channels is between 0.1 mm to 128 mm: wherein the number of fine channels per square meter of thermo-regulated surface is between 21 and 14000; wherein the fluid flows in the fine channels in such a way that the mean Reynolds number is maintained greater than 810 and less than 89000 and wherein the rugosity of the channels is at least 0.9 microns and less than 190 microns.[2280]A component comprising fine channels with an equivalent diameter between 0.1 mm to 128 mm, and at least one inlet collector and one outlet collector connected by more than one fine channel with a temperature gradient within the collector below 39° C.; wherein the temperature gradient between the two insertion points of the fine channels to the collectors, for the 12% of the fine channels whose temperature gradients between their two insertion points are greater, is more than 1.1° C.[2281]A component comprising fine channels and main channels; wherein the mean cross-section of the main channels is at least 3 times higher than the cross-section of the smallest channel among all the fine channels in the component area where the thermo-regulation is desired; wherein the number of fine channels per square meter of thermo-regulated surface is between 61 and 4000 and wherein the rugosity of the channels is at least 10.2 microns and less than 98 microns.[2282]A component comprising fine channels with a H value greater than 12 and less than 1098, being H=the total length of the fine channels/the mean length of the fine channels: wherein the equivalent diameter of the fine channels is between 0.1 mm to 128 mm; wherein the number of fine channels per square meter of thermo-regulated surface is between 21 and 14000; wherein the fluid flows in the fine channels in such a way that the mean Reynolds number is maintained greater than 810 and less than 89000; wherein the component comprises at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C.[2283]A component comprising fine channels with a H value greater than 12 and less than 230, being H=the total length of the fine channels/the mean length of the fine channels; wherein the equivalent diameter of the fine channels is between 1.2 mm and 18 mm; wherein the number of fine channels per square meter of thermo-regulated surface is between 61 and 4000; wherein the fluid flows in the fine channels in such a way that the mean Reynolds number is maintained greater than 2800 and less than 26000; wherein the component comprises at least one inlet collector and one outlet collector connected by more than one fine channel with a temperature gradient within the collector below 9° C. and wherein the temperature gradient between the two insertion points of the fine channels to the collectors, for the 20% of the fine channels whose temperature gradients between their two insertion points are greater, is more than 2.6° C.[2284]A component comprising fine channels and main channels; wherein the mean cross-section of the main channels is at least 6 times higher than the cross-section of the smallest channel among all the fine channels in the component area where the thermo-regulation is desired; wherein the distance from the fine channels to the surface to be thermo-regulated is between 0.6 mm and 32 mm: wherein the equivalent diameter of the fine channels is between 0.1 mm to 128 mm: wherein the number of fine channels per square meter of thermo-regulated surface is between 21 and 14000; wherein the fluid flows in the fine channels in such a way that the mean Reynolds number is maintained greater than 810 and less than 89000; wherein the rugosity of the channels is between 0.9 microns and 190 microns; wherein the component comprises at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C.[2285]A component comprising fine channels; and main channels; wherein the cross-section of the main channels is at least 3 times higher than the cross-section of the smallest channel among all the fine channels in the component area where the thermo-regulation is desired; wherein the distance from the fine channels to the surface to be thermo-regulated is between 1.2 mm and 19 mm; wherein the equivalent diameter of the fine channels is between 1.2 mm and 18 mm: wherein the number of fine channels per square meter of thermo-regulated surface is between 61 and 4000; wherein the fluid flows in the fine channels in such a way that the mean Reynolds number is maintained greater than 2800 and less than 26000; wherein the rugosity of the channels is at least 10.2 microns and less than 98 microns; wherein the component comprises at least one inlet collector and one outlet collector connected by more than one fine channel with a temperature gradient within the collector below 9° C. and wherein the temperature gradient between the two insertion points of the fine channels to the collectors, for the 20% of the fine channels whose temperature gradients between their two insertion points are greater, is more than 2.6° C.[2286]A component comprising fine channels with a mean length between 0.6 mm and 1.8 m, and at least one inlet collector and one outlet collector connected by more than one fine channel with a temperature gradient within the collector below 39° C.; wherein the temperature gradient between the two insertion points of the fine channels to the collectors, for the 50% of the fine channels whose temperature gradients between their two insertion points are greater, is more than 1.1° C. and less than 199° C.[2287]A component comprising fine channels with an equivalent diameter between 0.1 mm and 128 mm and at least one inlet collector and one outlet collector connected by more than one fine channel with a temperature gradient within the collector below 39° C. and wherein the temperature gradient between the two insertion points of the fine channels to the collectors, for the 50% of the fine channels whose temperature gradients between their two insertion points are greater, is more than 1.1° C. and less than 199° C.[2288]The component according to any of [1] to [2287], wherein the component is manufactured according to the method of any of [1] to [2287]. The method according to any of [1] to [2287], wherein the microwave heating comprises a highly pressure resistant magnetron which is introduced into the chamber. [2289]The method according to any of [1] to [2288], wherein the microwave heating comprises a pressurized chamber comprising at least one antenna or applicator. [2290]The method according to any of [1] to [2289], wherein the microwave heating comprises a pressurized chamber comprising at least one coaxial feedthrough.[2291]The method according to any of [1] to [2290], wherein the coaxial feedthrough has the proper impedance. [2292]The method according to any of [1] to [2291], wherein the proper impedance is between 1.1 Ohms and 199 Ohms. [2293]The method according to any of [1] to [2292], wherein the proper impedance is 21 Ohms or more. [2294]The method according to any of [1] to [2293], wherein the proper impedance is 99 Ohms or less. [2295]A component manufactured according to any of [1] to [2288]. [2296] The method according to any of [1] to [2295] wherein the step of “a forming step, wherein an additive manufacturing method is applied to form the component” is substituted by “a forming step comprising forming the component using an additive manufacturing method”. [2297] The method according to any of [1] to [2296] wherein the step of “—a consolidation step, wherein a consolidation treatment is applied” is replaced by “a consolidation step, comprising applying a consolidation treatment”. [2298] The method according to any of [1] to [2297] wherein the step of “a densification step, wherein a high temperature, high pressure treatment is applied” is replaced by “a densification step, comprising applying a high temperature, high pressure treatment”. [2299] The method according to any of [1] to [2298] wherein the step of “a fixing step, wherein the oxygen and/or nitrogen level of the metallic part of the component is set“is replaced by” a fixing step, comprising setting the oxygen and/or nitrogen level of the metallic part of the component”. [2300] The method according to any of [1] to [2299] wherein the step of “a forming step, wherein the component from the powder or powder mixture comprising at least a metal or a metal alloy in powdered form using a metal additive manufacturing (MAM) method is formed” is replaced by “a forming step, comprising forming the component from the powder or powder mixture comprising at least a metal or a metal alloy in powdered form using a metal additive manufacturing (MAM) method. [2301] The method according to any of [1] to [2300] wherein the step of “a forming step, wherein the component is formed by applying a pressure and/or temperature treatment to the mold” is replaced by “a forming step, comprising applying a pressure and/or temperature treatment to the mold. [2302] The method according to any of [1] to [2301].[2302] The method according to any of [1] to [2301] wherein the microwave heating is made in a chamber comprising a coaxial cable or coaxial feedthrough with the proper dimension. [2303] The method according to any of [1] to [2302] wherein the proper dimension is a nominal outer diameter (OD) of 7/32″ or more. [2304] The method according to any of [1] to [2303] wherein the proper dimension is a nominal outer diameter (OD) of 4- 1/16″ or less.

Some test conditions are as follows:

In this document, when no otherwise indicated, Tm refers to the absolute temperature where the first liquid is formed in equilibrium conditions.

In an embodiment, the melting temperature of the powder material is measured according to ASTM E794-06 (2012).

In an embodiment, the values of HDT are determined according to ASTM D648-07 standard test method.

In an alternative embodiment, HDT is determined according to ISO 75-1:2013 standard.

In another alternative embodiments, the melting temperature can be measured employing thermogravimetry or any other characterization technique in a very simple way also by DSC, or by DTA, or even by DTA with STA.

In another alternative embodiment, the HDT is the HDT reported for the closest material in the UL IDES Prospector Plastic Database at 29/01/2018.

The HDT test conditions to determine deflection temperature measured according to ASTM D648-07 standard test method with a load of 0.455 MPa [66 psi] or 1.82 MPa [264 psi] are disclosed below.

Heat deflection temperature is measured in an automated apparatus, with silicon oil as liquid heat-transfer medium up to 250° C., for higher temperatures graphite powder is employed as heat-transfer medium (and a thermocouple calibrated according to ASTM E2846-14 instead a thermometer for temperature measurement) 3 specimens are used of 3 mm width according to ASTM D648-07 Method A, with loads of 0.455 MPa [0.66 psi] or 1.82 MPa [264 psi], the load used is indicated for each measure. Prior to the analysis test specimens and bath are equilibrated at 30° C., heating rate is 2° C./min. Test specimens are obtained according to molding methods A to C disclosed below. When a specimen can be obtained by more than one molding method (A to C), the specimen obtained by each method is tested and the highest value obtained is the value selected of heat deflection temperature.

Preparation of test specimens: the mold used to obtain the test specimen for heat deflection temperature is 127 mm in length, 13 mm when HDT is measured according to ISO 75-1:2013 Method B test with a load of 0.455 MPa or 1.82 MPa (the load used is indicated for each measure).

Glass transition temperature (Tg) is measured by differential scanning calorimetry (DSC) according to ASTM D3418-12. Weight of the sample 10 mg. In a ceramic container. Purge gas used argon (99.9%) at flow rate 25 ml/min. Heating/cooling rates 10° C./min. For liquid polymers or resins, after pulverization the sample is polymerized according to molding methods A to C disclosed below to obtain a test specimen, and then the sample is pulverized. When a specimen can be obtained by more than one molding method (A to C), the specimen obtained by each method is tested and the highest value obtained is the value selected of Tg.

Molding methods:

Molding method A. Photopolymerization is carried using a photo-initiator. Photo-initiator (type, percentage) is selected in accordance with the recommendations of the supplier. If not provided, the photo-initiator used is Benzoyl peroxide, 2 wt %. A mold with the required dimensions in function the specimen required is filled with a homogeneous mixture between the resin and the photo-initiator. The mixture is polymerized according to the cured conditions provided by the supplier (wavelength, and time of exposure), if not provided the material is cured under UV lamp (365 nm, 6 W) for 2 h. After this time the specimen is removed from the mold and the bottom part is also cured in the same conditions as upper part. The cure is carried out in a closed light insulating box, where only the radiation of the lamp incident in the specimen, which is 10 cm away from the light source.

Molding method B. Thermoforming is carried in a conventional thermoforming machine, the required amount of material to obtain 3 mm in thickness is clamped in the frame of the mold. Once the material sheet is secured in the heating area, it is heated to forming temperature, which is selected in accordance with the supplier recommendations, if not provided, temperature selected is 20° C. below the glass transition temperature (Tg). Once specimen is in the mold, is cooled to 25° C. The excess material to obtain the required specimen is removed.

Molding method C. Injection molding is carried in a conventional injection molding machine. Plastics pellets are selected as raw material when available, if not the different chemical components are injected into the barrel. The material is heated up the temperature and during the time recommended by the supplier, if not provided, the material is heated to a temperature 10° C. above their melting temperature and maintained for 5 minutes (when the degradation point of the material is more than 50° C. higher than the melting temperature) or 20° C. above the glass transition temperature (Tg) of the material (if the degradation point is less than 50° C. higher than the melting temperature).

As used in this document, unless otherwise stated, room temperature is 23° C.

In this document, unless otherwise stated, the measurements are at 1 atm and room temperature (23° C.).

In this document, unless otherwise stated, pressures expressed in mbar are absolute pressure values, and pressures expressed in bar and/or MPa are relative pressure values.

In an embodiment, all pressures indicated in this document (only pressures defined as positive pressures and not vacuum levels) are expressed as PRESS+1 bar, where PRESS is the absolute pressure level. In an embodiment, all vacuum levels described in this document are expressed in absolute pressure values.

As used in this document, the term “and/or” used in the context of “x and/or y” should be interpreted as “x,” or “y,” or “x and y.”

As used in this document, oxygen (% O) refers to ppm of O₂ measured according to ASTM-751-14a unless explicitly stated otherwise.

As used in this document, nitrogen (% N) refers to ppm of N₂ measured according to ASTM-751-14a unless explicitly stated otherwise.

Further features and advantages of the present invention become clear from the following description of some examples.

Example 1: Parts of a mold were manufactured by SLS 3D printing of PP powder. The parts were ensembled together and the mold filled with a mixture of three powders: two of them being more than 96% iron, one water atomized and the other obtained through the carbonyl process. The third powder a highly alloyed powder with less than 50% k iron a gas atomized powder. The filled mold was covered with a lid on the open face where the powder filling took place and the lid was welded to the mold with an electronics solder. The sealed mold was placed in a bag made with two sheets of FKM elastomer glued together and where additionally the borders were kept together by a metallic frame. The FKM bag was additionally filled with a linear Polydimethylsiloxane oil presenting a viscosity of 20000000 cSt. The bag was then placed in a container which was then inundated with a water solution (35% polypropylenglycol) and subjected to a pressure of 600 bar. Then the temperature was raised to 100° C. and maintained for 2 h. Then the pressure was raised to 3200 bars while the temperature was raised to 180° C. Then, the pressure and temperature where hold rather constant for 2 h. Then the pressure was released slowly. Finally the temperature was decreased while opening the container and extracting the FKM bag. A compacted piece with the defined shape of the mold (with the expected contraction) and high green strength was obtained.

Example 2: To test the possibility of heating with microwaves and the advantages thereof, a mold like in the preceding example (Example 24) was manufactured and placed in the same FKM bag (this time without a metallic frame). Also the bag was filled with a linear Polydimethylsiloxane oil this time presenting a viscosity of 1000000 cSt. The filled and sealed with glue FKM bag was placed in a borosilicate glass container and filled with a polyalphaolefin fluid and the glass container was placed in a cylindrical chamber microwave oven with 2.45 GHz and 600 W magnetron. The oven was kept on during 5 minutes. As a result, the glass, polyalphaolefin, FKM bag and the linear Polydimethylsiloxane oil all experimented a light heating (below 100° C.) but the metallic powder filling the mold heated up to more than 200° C. and melted the internal features of the mold and also part of the external features. To conclude the feasibility, the green piece of the preceding experiment was covered with the linear Polydimethylsiloxane oil with a viscosity of 20000000 cSt of the previous experiment and a pressure of 3200 bars was applied. There was no infiltration of the linear Polydimethylsiloxane oil into the compressed powder, indicating that if microwave radiation had been used for heating in the previous experiment, leading to the melting of the PP mold and thus a direct contact of the linear Polydimethylsiloxane oil and the pressed piece taking place, there would be no infiltration and thus destruction of the piece. This would reduce the time required for step ii) very considerably.

Example 3. Several gears were manufactured by BJ with powder compositions according to the invention and using a liquid polymer as the binder. The metallic materials of examples 1, 3, 4, 11 to 15 and 16 to 30 were tested. The apparent density of the metallic part of the additively manufactured gears was between 46% k and 69% and the % NMVC in the metallic part of the gears was between 29% and 52% before introduced in a furnace where the binder was removed through thermal pyrolysis at a temperature between 190° C. and 680° C. (in a few cases part of the debinding was done chemically). Several atmospheres were tested in the debinding: Ar, N₂, H₂, an organic gas and/or mixtures thereof and/or the chamber of the furnace was just evacuated and the pyrolysis was realized under vacuum. To some of the gears a pressure treatment was applied (pressures ranged from 210 MPa to 640 MPa). To some of the gears a pressure and/or temperature treatment was applied (maximum temperatures ranging from 90° C. to 280° C., with most of the tests performed with a maximum temperature between 160° C. and 245° C., pressures tested raged from 110 MPa to 590 MPa with most of the tests performed in the 210 MPa to 480 MPa range). In some cases the pressure and/or temperature treatment was applied with a microwave heating system, in which cases the maximum temperatures were higher (up to almost 600° C. and even more in a couple special tests). The pressure and/or temperature treatments were applied in some cases prior to the debinding step and in some cases after the debinding step. In some cases, the gears were applied a pressure and/or temperature treatment as they were and in some cases they were previously encapsulated. Several encapsulation methods were employed (like polymeric films, vacuumized bags, conformal coatings, molds, etc.) and several elastomers and other polymeric materials were used for the encapsulation. Some of the gears where a pressure and/or temperature treatment was applied were amongst the ones with highest apparent density when tested, especially those where a high pressure—high temperature treatment was applied after the consolidation treatment. Some of the gears were consolidated in the same furnace and using the same atmosphere that was used for the binder removal but in some cases the atmosphere was changed to Ar, H2 N2, O2, an organic gas, a nitriding atmosphere and/or mixtures thereof and/or vacuum in the range between 0.9*10−3 mbar and 0.1*10−9 mbar. Often the consolidation was performed in a different furnace than the debinding. In all cases, heating ramps and dwells were chosen as a function of material and atmosphere to set the proper % O and % N levels. In some gears the fixing of the % O was set at rather low levels, between 0.6 and 120 ppm (those with levels below 48 ppm and even more so those with levels below 19 ppm seem to have rather better performance). In some other gears the % O was set at rather high levels, between 610 and 9000 ppm (those with levels above 1200 ppm and even more so those with levels above 4100 ppm seem to have tendentially higher hardness). In some gears the fixing of the % N was set at rather low levels, between 0.06 and 99 ppm (those with levels below 48 ppm and even more so those with levels below 14 ppm seem to have rather better performance in terms of cracking during test). In some other gears the % N was set at rather high levels, between 0.26% and 2.9% (those with levels above 0.4% and even more so those with levels above 0.8% seem to have higher resistance to buckling). In most cases, temperatures between 0.46*Tm and 0.92*Tm were reached during the consolidation treatment. In some cases, there was a liquid phase formed during the consolidation heat treatment (between 0.2% and 19%). In the cases where a liquid phase was formed higher temperatures were reached between 1.02*Tm and 1.29*Tm. After the consolidation heat treatment apparent densities were between 86% and 99.8%, % NMVC between 0.002% and 4%, the reduction of % NMVS mostly between 2.1% and 6%.

Some of the gears were transferred to a pressure vessel and subjected to a high temperature, high pressure treatment at a maximum (in some cases mean) pressure between 320 and 2800 bar and a maximum (in some cases mean) temperature between 0.55*Tm and 0.92*Tm in an inert atmosphere. The apparent densities after the high pressure, high temperature treatment were above 96% (in most cases above 98.2%) and in some cases full density was achieved, but most cases had an apparent density below 99.98%. The % NMVC of the gears after the high temperature, high pressure treatment were between 0.002% and 9% (in most cases between 0.02 and 1.9% and in some cases % NMVC was 0%). The reduction of % NMVS and % NMVC from the additively manufactured component to after the high pressure, high temperature treatment were mostly between 20% and 96% with some cases below and some cases approaching or even reaching 100%.

The gears were also manufactured with conventional BJ with similar alloys (in terms of at least two main alloying elements). All gears were cycled under load incrementing the load every 20.000 cycles. All gears of the present example outperformed the ones manufactured with conventional BJ with at least 15% more load capacity. Also, some of the gears presented some other very relevant advantages like improved physical properties, thermal properties, corrosion resistance, etc.

The relevant thermal properties attainable are shown in the following tests:

Several 100 gr gears were manufactured by BJ with a metallic powder having the following composition, all percentages being in weight percent: ° C.=0.42: % Cr=0.02: % Ni=1.08; % V=0.46; % Mo=3.28; % P=0.004; % Si=0.04; % Mn=0.08; % S=0.0008; *% O=648 ppm; % N=437 ppm, the rest being iron and trace elements (trace elements in total less than 0.4 wt %), and a particle size distribution (**D10=18.6; D50=30.9; D90=44.1; average=31.9); a mixture of ethylene glycol monomethyl ether and diethylene glycol was used as binder. [in some tryouts the metallic powder was incorporated as above but with % C<0.1% and then either admixed with graphite, treated in a carburizing atmosphere or even using the binder as % C source to get a final composition of the metallic part with % C˜0.42. In some tryouts a binomial mixture of particle sizes was used. In some tryouts a mixture of powders were used adding up to the here expressed composition, with several of those tryouts incorporating different amounts of carbonyl iron]. The apparent density of the metallic part of the additively manufactured gears was around 54% and the % NMVC in the metallic part of the additively manufactured gears was around 43% before introducing each of the gears into a furnace where the binder was removed and the gear consolidated. For the removal of the binder in this case three different setups were employed one with the usage of a H₂ atmosphere, another one using a low % O₂ content Ar atmosphere and the last one evacuating the chamber of the furnace—in this case the chamber was roughly evacuated to around 10−4 mbar and then flooded with Ar and afterwards the chamber was evacuated to a vacuum level between 10−4 and 10−5 mbar—in all three cases the temperature profile comprised a hold at 260° C. and in some cases a second one at 440° C. The heating was mainly through convection for the binder removal. After the thermal removal of the binder, which in the cases where only a hold at 260° C. was made might have been incomplete, a heating until 620° C. was performed and an isothermal dwell to stabilize temperature, and from this point on the heating was made mainly through radiation until a maximum temperature of 1280° C. (in a few cases 1350° C. were employed as maximum temperature) for temperatures above 900° C. a vacuum level between 10−6 and 10−10 mbar was employed. The % O and % N levels in the gears after the consolidation treatment were in all cases below 140 ppm and below 49 ppm, respectively (in several cases below 29 ppm and 19 ppm respectively). In many cases % O was set to more than 0.2 ppm and % N to more than 0.05 ppm. The apparent densities were between 96% and 99.4%.

Several gears were transferred to a pressure vessel and subjected to a high temperature, high pressure treatment.

For comparative purposes, some gears were manufactured using additive manufactured molds filled with metallic materials in particulate form as described in this document. The molds were manufactured as described in example 11 (although some tests were performed also with the molds manufactured as in tests 5, 6 and 12 to 15) and the filling and Pressure and/or Temperature treatment was made as described in examples 12 to 15. Consolidation and densification were made identical to the other tests of this example (with all the different configurations). Thermal diffusivities above 12 mm²/s and in some cases even above 15 mm²/s were obtained with more than a 50% increase in load capacity.

The apparent density, load capacity (compared to the mean of the gears manufactured by means of conventional BJ) and thermal diffusivity properties (in the case of the conventional BJ gears values were always below 9 mm²/s)1 of the gears are shown in table below.

| | Apparent | | Thermal |
|---|---|---|---|
| Gear | Density | Load capacity | Diffussivity1 |
| Sample 1 | 99.5% | +23% | 14.21 |
| Sample 2 | 99.91% | +52% | 11.40 |
| Sample 3 | 99.96% | +38% | 12.18 |

1Measured at room temperature (23° C.) according to ASTM E1461-13: Standard Test Method for Thermal Diffusivity by the Flash Method.
*% O was measured as ppm of O2 and % N was measured as ppm of N2 (ASTM-751-14a).
***Particle size was measured by laser diffraction according to ISO 13320-2009.

The relevant mechanical properties attainable are shown in the following tests:

Several 100 gr gears were manufactured by BJ with a metallic powder mixture having the following overall final composition, all percentages being in weight percent: % Cr=17-27; % Ni=0.01-14; % Mo=0.003-6%; % Si<1.5: % Mn=0.008-19%; % S<0.08; % P<0.09: % W<5; % V<0.8; % Ti=0.00001-1.9; % Yeq(1)-0.22-4; *%0=500-9.900 ppm; % N=1200-25000 ppm, the rest being iron and trace elements (trace elements in total less than 0.4 wt %). Some of the gears had % Cr, % Mo, % V, % Nb, % W, % Ti and/or % Fe comprising nitride —including carbo-nitro-oxo-boro nitrides where % C, % N, % B and/or %⁰ were often missing-. All tested gears had acceptable results but some considerably better than others, amongst other things that could be related to particular narrow selections of composition. (as an example, gears with % Cr=19.5-25.5; % Ni=4.5-11; % Mo=0.003-4.5%; % Si<0.09; % Mn=0.008-6%; % S<0.01; % P<0.01; % W<3; % V<0.08; % Ti=0.00001-1.1: % Yeq(1)=0.78-2.5; *% O=2100-6800 ppm; % N=4000 12000 ppm and KYI=2600 and KYS=3000, where at least 70% of the % N was introduced as a % Cr and/or % Fe comprising nitride —including carbo-nitro-oxo-boro nitrides where % C, % N, % B and/or %⁰ were often missing—were amongst the high performant). Several polymers were used as binder. The apparent density of the metallic part of the additively manufactured gears was between 48% and 66% and the % NMVC in the metallic part of the additively manufactured gears was between 33% and 49% before introducing each of the gears into a furnace where the binder was removed. For the removal of the binder in this case several atmospheres were employed for thermal pyrolysis and temperatures between 200° C. and 650° C., but in some cases chemical removal of the binder was employed, at least partially. In some cases the debinded gears were subjected to a % O fixing step consisting on the treatment under a O2 comprising atmosphere (between 0.02 vol % and 49 vol %) and where temperatures between 210° C. and 490° C. were maintained for times between 1 and 49 hours (in most cases the treatments were longer than 2.5 h) in those cases levels of O2 between 1100 and 9900 ppm were reached in the final component (in several cases between 2200 and 6900 ppm). In some cases the gears were subjected to a high temperature fixing step for nitrogen in a moderate atomic nitrogen comprising atmospheres (for example: atomic nitrogen [between: 0.078-46.8 mol %, and in several cases between 0.78-15.21 mol %], NH3 [between: 0.11-49 vol %] and maximum temperatures of exposition to this atmospheres between 580° C. and 1440° C. [in several cases between 655° C. and 1290° C.]). Overall, the % N was set at rather high levels, between 0.22% and 2.9% (those with levels above 0.4% and even more so those with levels above 0.8% seem to have higher resistance to buckling). Several gears were consolidated trough a high temperature treatment (highest temperatures between 0.45 Tm and 0.92 Tm, with several of the treatments made with a highest temperature between 0.55 Tm and 0.88 Tm) in a proper atmosphere mostly comprising N2, a noble gas (like Ar, He, . . . ), H2, an organic gas or mixtures of those (like Ar+H2, N2+H2, mixtures of several organic gases, . . . ). In some cases, the consolidation treatment comprised a step performed under a proper atmosphere consisting on vacuum in the range between 0.9*10-3 mbar and 0.6*10-9 mbar (in fact some of the gears processed in this way, and even more so those processed under a vacuum between 0.6*10-5 mbar and 0.6*10-9 mbar, seemed to present particularly good results). After the consolidation heat treatment apparent densities were between 96% and 99.96%, % NMVC between 0.002% and 4%, the reduction of % NMVS mostly between 3.6% and 96%. Some of the gears were transferred to a pressure vessel and subjected to a high temperature, high pressure treatment as described above. Some of the gears presented full density at this stage (others had apparent densities between 98.2% and 99.98%). Some of the gears presented % NMVC and/or % NMVS of 0% (some others presented % NMVC between 0.002% and 1.9%, % NMVS between 0.002% and 2%) All gears of the present example outperformed the ones manufactured with conventional BJ with at least 80% more load capacity under static loading, in some cases the load capacity was more than 10×higher, which is a formidable result. For comparative purposes, some gears were manufactured using additive manufactured molds filled with metallic materials in particulate form as described in this document. The molds were manufactured as described in example 11 (although some tests were performed also with the molds manufactured as in tests 5, 6 and 12 to 15) and the filling and Pressure and/or Temperature treatment was made as described in examples 12 to 15. Consolidation and densification were made identical to the other tests of this example (with all the different configurations). Results were comparable and in several cases significantly better.

Example 4. Several test components were manufactured using additive manufacturing methods comprising an organic material and comprising as well a metallic material in particulate form (technologies based on material extrusion like FDM/FFF: technologies based on vat photopolymerization like SLA, DLP, with DLS—Digital Light Synthesis—or similar technologies based on CLIP—Continuous Liquid Interface Production, continuous digital light processing (CDLP), —: technologies based on bed fusion—PBF— like SLS, SHS—Selective Heat Sintering —; technologies based on material jetting like MJ, DOD, DIW—Direct Ink Writing-where some thermoset polymers like epoxy and even reinforced epoxi: technologies based on binder jetting like BJ, MJF; and even technologies based on direct energy deposition—DED—; also the different BAAM configurations described in this document were tested) while it was possible to achieve satisfactory results with all of these technologies, several provided good results and a few provided exceptional results. Some of the manufactured components were manufactured using the strategies of examples 3, 5 and 6, while it was possible to achieve satisfactory results with all of this manufacturing strategies, several provided good results and a few provided exceptional results. The organic materials described in this document were used, amongst many others the materials described in examples 1, 2, 3, 5, 9, 11, and 12 to 15 were tested, while it was possible to achieve satisfactory results with all of these organic materials, several provided good results and a few provided exceptional results. The metal comprising materials described in this document were used, amongst many others the materials described in examples 1, 3, 11 to 15, and 16 to 30 were tested, while it was possible to achieve satisfactory results with all of these metal comprising materials, several provided good results and a few provided exceptional results. Certain particular advantages were found depending on the technology and materials used, but the performance was ensured regardless of the technology and materials employed. The high performance achieved in several of these components in terms of mechanical performance was unmatched by existing more traditional conventional and MAM technologies. For exemplification purposes one amongst the hundredths of tests performed in this example will be further discussed:

Within the technologies based on material extrusion like FDM/FFF several organic materials were tested as already mentioned, and in some tests more in depth analysis was made with PLA, ABS, TLCPs —Thermotropic Liquid Crystaline Polymers —, PS, PPE, PP, PA, PEI, PEEK. PEKK, PAI, PVDF, PPSU, PPS, PES, PSU, PC, PVA, TPU, TPE, PET, POM, PCL, PLGA, PBT, SAN, ASA, HIPS, PEVA, PMMA, and some mixtures thereof as organic materials for the wire. PLA, ABS, TPU, PCL and HIPS were tested blended with practically all the metallic materials described in this document. All other organic materials were at least tested blended with the metallic comprising particulate materials of examples 1, 3, 5, 11 to 15, and 16 to 30.

The apparent density of the metallic part of the additively manufactured components was between 31% and 79.8% and the % NMVC in the metallic part of the components was between 12% and 49% before debinding. Debinding was made by chemical means or pyrolysis, introduced in a furnace where the binder was removed through thermal pyrolysis at a temperature between 190° C. and 680° C. Several atmospheres were tested in the debinding: Ar, N2, H2, an organic gas and/or mixtures thereof and/or the chamber of the furnace was just evacuated and the pyrolysis was realized under vacuum. To some of the components a pressure treatment was applied (pressures ranged from 60 MPa to 1200 MPa). To some of the components a pressure and/or temperature treatment was applied (maximum temperatures ranging from 86° C. to 298° C., with most of the tests performed with a maximum temperature between 110° C. and 249° C., pressures tested raged from 110 MPa to 640 MPa with most of the tests performed in the 220 MPa to 590 MPa range). In some cases the pressure and/or temperature treatment was applied with a microwave heating system, in which cases the maximum temperatures were higher (up to almost 600° C. and even more in a couple special tests). The pressure and/or temperature treatment were applied in some cases prior to the debinding step and in some cases after the debinding step. In some cases, the components were applied a pressure and/or temperature treatment as they were and in some cases they were previously encapsulated. Several encapsulation methods were employed (like polymeric films, vacuumized bags, conformal coatings, molds, etc.) and several elastomers and other polymeric materials were used for the encapsulation (the ones mentioned in this document). Some of the components where a pressure and/or temperature treatment was applied were amongst the ones with highest apparent density when tested, especially those where a high pressure—high temperature treatment was applied after the consolidation treatment. Some of the components were consolidated in the same furnace and using the same atmosphere that was used for the binder removal but in some cases the atmosphere was changed to Ar, H2 N2, O2, an organic gas, a nitriding atmosphere and/or mixtures thereof and/or vacuum in the range between 0.9*10−3 mbar and 0.1*10−9 mbar. Often the consolidation was performed in a different furnace than the debinding. In all cases, heating ramps and dwells were chosen as a function of material and atmosphere to set the proper % O and % N levels. In some components the fixing of the % O was set at rather low levels, between 0.2 and 90 ppm (those with levels below 49 ppm and even more so those with levels below 19 ppm seem to have rather better performance). In some other components the % O was set at rather high levels, between 520 and 14000 ppm (those with levels above 1100 ppm and even more so those with levels above 2500 ppm seem to have tendentially higher hardness). In some components the fixing of the % N was set at rather low levels, between 0.02 and 99 ppm (those with levels below 49 ppm and even more so those with levels below 19 ppm seem to have rather better performance in terms of cracking during test). In some other components the % N was set at rather high levels, between 0.2% k and 3.9% (those with levels above 0.6% and even more so those with levels above 0.91% seem to have higher resistance to buckling). In most cases, temperatures between 0.36*Tm and 0.96*Tm were reached during the consolidation treatment. In some cases, there was a liquid phase formed during the consolidation heat treatment (between 0.2% and 29%). In the cases where a liquid phase was formed higher temperatures were reached between 1.02*Tm and 1.29*Tm. After the consolidation heat treatment apparent densities were between 81% and 99.8%, % NMVC between 0.002% and 9%, the reduction of % NMVS mostly between 2.1% and 61%.

Some of the components were transferred to a pressure vessel and subjected to a high temperature, high pressure treatment at a maximum (in some cases mean) pressure between 160 and 4900 bar and a maximum (in some cases mean) temperature between 0.45*Tm and 0.92*Tm in an inert atmosphere. The apparent densities after the high pressure, high temperature treatment were above 96% (in most cases above 98.2%) and in some cases full density was achieved, but most cases had an apparent density below 99.98%. The % NMVC of the components after the high temperature, high pressure treatment were between 0.002% and 9% (in most cases between 0.01% and 1.9% and in some cases % NMVC was 0%). The reduction of % NMVS and % NMVC from the additively manufactured component to after the high pressure, high temperature treatment were mostly above 56% with some cases below and some cases approaching or even reaching 100%.

The components were also manufactured with conventional FDM based MAM with similar alloys (in terms of at least two main alloying elements). The conventionally processed components presented much lower elongation at break, fracture toughness and fatigue strength.

The relevant physical and mechanical properties attainable are shown in the following tests:

Several larger components were manufactured by FFF and several organic materials were tested (PLA, ABS, TPU, PCL, PVA, HIPS and PEEK) as organic materials for the wire, with a metallic powder having the following composition, all percentages being in weight percent: % Al=6.20; % V=4.01: % Fe=0.17; % C=0.011; % Y=0.002; *% O=1400 ppm; % H=32 ppm; % N=140 ppm, the rest being titanium and trace elements (trace elements in total less than 0.6 wt %), and a particle size distribution (**D10=7; D50=14; D90=21; Tap density=3 g/cm3). In some tryouts a binomial mixture of particle sizes was used with around 27% fine and 73% coarse powder the overall particle size distribution was (**D10=9; D50=53: D90=135; Tap density=3.4 g/cm3) with peaks at around 11 microns and around 70 microns. The apparent density of the metallic part of the additively manufactured components was around 52.5% for the single peak distribution and 62.0% for the binomial distribution and the % NMVC in the metallic part of the additively manufactured components was around 44% and 35% before introducing each of the components into a furnace where the binder was removed. In some cases the binder was mainly removed chemically with a solvent (like the case of HIPS and PVA) and in other cases mainly thermally. For the thermal removal of the binder in this case three different setups were employed one with the usage of a H2 atmosphere, another one using a low % O₂ content Ar atmosphere and the last one evacuating the chamber of the furnace—in this case the chamber was roughly evacuated to around 10−4 mbar and then flooded with Ar and afterwards the chamber was evacuated to a vacuum level between 10−5 and 10−7 mbar—in all three cases the temperature profile comprised a hold at 260° C. and in some cases a second one at 440° C. and in some cases a third one at 620° C. After the thermal removal of the binder, the components were consolidated by means of radiation heating, microwave heating (with 2.45 GHz and 6000 W total emitter power) or spark plasma sintering. The maximum temperature employed for the consolidation was 1100° C. (in a few cases 1250° C. were employed as maximum temperature and even up to 1350° C. in a few cases) for temperatures above 900° C. a vacuum level between 10−6 and 10−10 mbar was employed. The % O and % N levels in the components after the consolidation treatment were in all cases below 150 ppm and below 36 ppm, respectively (in several cases below 44 ppm and 14 ppm respectively). In some cases % H levels below 2 ppm were attained. The apparent densities were between 93% and 99.85%.

For comparative purposes, some components were manufactured using additive manufactured molds filled with metallic materials in particulate form as described in this document. The molds were manufactured as described in example 11 (although some tests were performed also with the molds manufactured as in tests 5, 6 and 12 to 15) and the filling and Pressure and/or Temperature treatment was made as described in examples 12 to 15. Consolidation and densification were made identical to the other tests of this example (with all the different configurations). Results were comparable and in several cases even noticeably better.

Several components were transferred to a pressure vessel and subjected to a high temperature, high pressure treatment, achieving full density in several cases.

The apparent density, elongation at break, yield strength and fatigue limit were in all cases above those reported in the literature for additively manufactured titanium components where the shaping of the metallic particles is done at a temperature below 0.5 Tm, in particular the values for deformation at break were in all cases at least twofold and in some cases 10× higher.

*% O was measured as ppm of O2 and % N was measured as ppm of N2 (ASTM-751-14a).

***Particle size was measured by laser diffraction according to ISO 13320-2009.

Example 5. Several dies and other components with cooling channels were manufactured using additive manufacturing methods comprising an organic material and comprising as well a metallic material in particulate form (technologies based on material extrusion like FDM/FFF; technologies based on vat photopolymerization like SLA, DLP, DLP projecting holograms and should also have worked with DLS—Digital Light Synthesis—or similar technologies based on CLIP—Continuous Liquid Interface Production, continuous digital light processing (CDLP), —: technologies based on bed fusion—PBF— like SLS, SHS—Selective Heat Sintering —; technologies based on material jetting like MJ, DOD; technologies based on binder jetting like BJ, MJF; and even technologies based on direct energy deposition—DED—; also some heads with some of the technologies mentioned in this paragraph were mounted on very large printers for BAAM) while it was possible to achieve satisfactory results with all of these technologies, several provided good results and a few provided exceptional results. Some of these dies and other components comprising cooling channels were manufactured using the strategies of examples 3, 4 and 6, while it was possible to achieve satisfactory results with all of this manufacturing strategies, several provided good results and a few provided exceptional results. The organic materials described in this document were used, amongst many others the materials described in examples 1, 2, 3, 4, 9, 11, and 12 to 15 were tested, while it was possible to achieve satisfactory results with all of these organic materials, several provided good results and a few provided exceptional results. The metal comprising materials described in this document were used, amongst many others the materials described in examples 1, 3, 4, 11 to 15 and 16 to 30 were tested, while it was possible to achieve satisfactory results with all of these metal comprising materials, several provided good results and a few provided exceptional results. Certain particular advantages were found depending on the technology and materials used, but the performance was ensured regardless of the technology and materials employed.

Several dies and other components with cooling channels were manufactured using additive manufacturing methods comprising a metallic material in particulate or wire form (technologies based on bed fusion—PBF— like DMLS, SLM, EBM, and even SLS; technologies based on direct energy deposition—DED—, in this case several technologies based on different welding principles were also tested; Joule printing was also tested: also some heads with some of the technologies mentioned in this paragraph were mounted on very large printers for BAAM), while it was possible to achieve satisfactory results with all of these technologies, several provided good results and a few provided exceptional results. Some of these dies and other components comprising cooling channels were manufactured using the strategies of example 31, while it was possible to achieve satisfactory results with all of these strategies, several provided good results and a few provided exceptional results. The metal comprising materials described in this document were used, amongst many others the materials described in examples 1, 3, 4, 11 to 15 and 16 to 30 were tested, while it was possible to achieve satisfactory results with all of these metal comprising materials, several provided good results and a few provided exceptional results. Certain particular advantages were found depending on the technology and materials used, but the performance was ensured regardless of the technology and materials employed. Some examples,

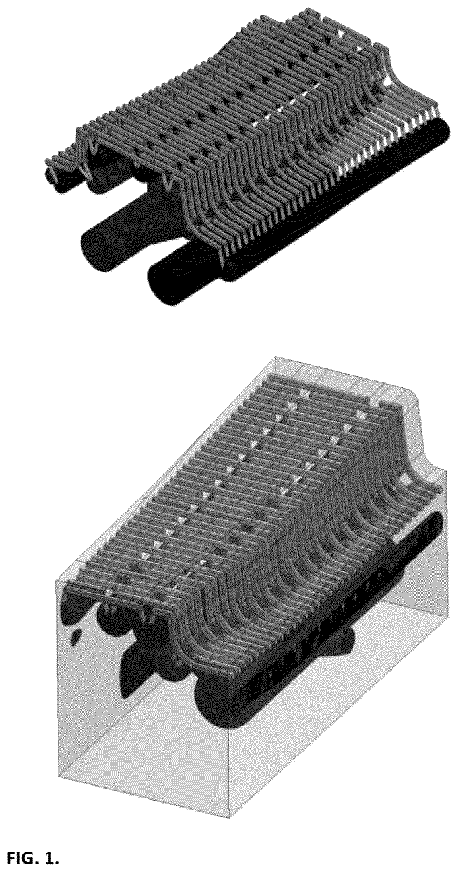

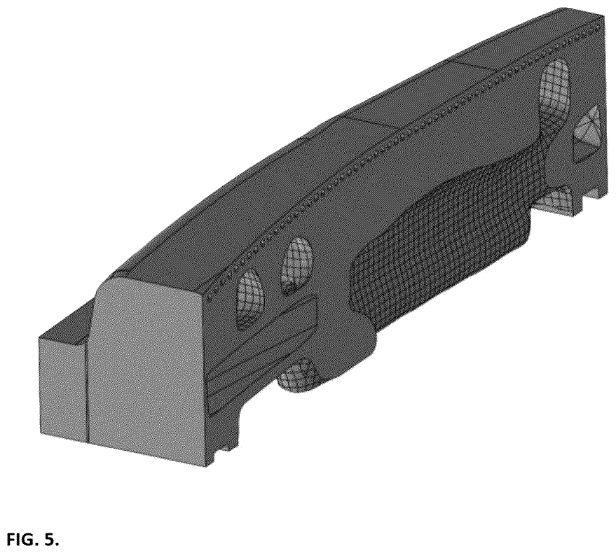

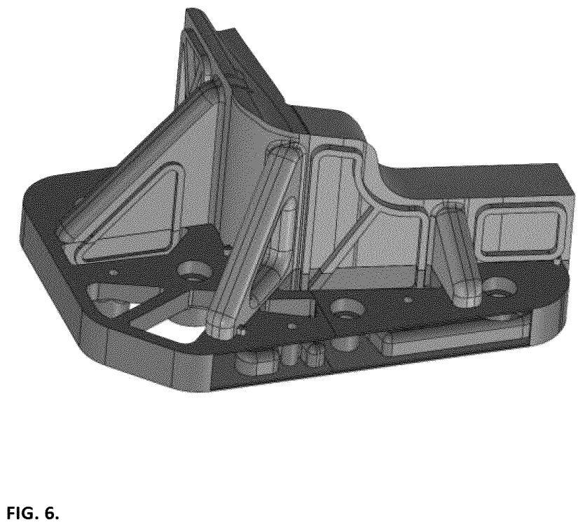

Several dies and other components with cooling channels were manufactured using additively manufactured molds filled with metallic materials in particulate form. The molds were manufactured as described in this document, the cases described in examples 1, 11 and 13 to 15 were also tested (in some tests, the molds were manufactured using several technologies: FDM, FFF; SLA, DLP, DLP projecting holograms, DLS based on CLIP, CDLP, SLS, SHS, MJ, DOD; BJ, MJF; DED—; BAAM with a print head similar to FDM, FFF or even DED), while it was possible to achieve satisfactory results with all of these technologies, several provided good results and a few provided exceptional results. The organic materials mentioned in this document were used to manufacture the molds, amongst them the materials included in examples 1, 2, 3, 4, 9, 11, and 12 to 15, while it was possible to achieve satisfactory results with all of these organic materials, several provided good results and a few provided exceptional results. The metal comprising materials described in this document were used to fill the molds, amongst them those included in examples 1, 3, 4, 11 to 15 and 16 to 30, while it was possible to achieve satisfactory results with all of these metal comprising materials, several provided good results and a few provided exceptional results. The manufacture of the dies and other components was performed according to the manufacturing steps described in this document, all the ones mentioned in examples 11 to 15, 8, 19 and 9 were also tested. Certain particular advantages were found depending on the technology and materials used, but the performance was ensured regardless of the technology and materials employed. Some examples can be seen in FIG. 1, FIG. 5 and FIG. 6—3 middle segments—.

In some cases the cooling channels were in fact used to heat-up the component by circulating a hot fluid trough them, so the tested circuits could more generally be described as thermo-regulation channels than the more particular case of cooling-channels. In most cases the configuration of the cooling channels comprised one or a plurality of main channels for the thermo-regulation fluid inlet (that since in almost all cases water was tested amongst other fluids, in this example water and thermo-regulation fluid are used indistinctively). Often these main channels comprised one or more primary channel, with or without branches and often with one or more secondary channels which in turn sometimes had one or more tertiary channels, which in turn sometimes had one or more quaternary channels and so on and so forth. In the same way, although often with different particular configuration there was a main channel or main system of channels (primary, secondary, tertiary, quaternary, etc.) for the water outlet. In the cases referred to in this paragraph, several of the fine channels, if not all, were “connecting” the main water inlet cannel or system of channels and the main water outlet channel or system of channels. In some of these cases either the water inlet cannel or system of channels or the main water outlet channel or system of channels or both acted as a “collector” in the sense that there was a very low temperature gradient between fine channels insertion points within one “collector” inlet or outlet had very small temperature gradients within themselves (the differences in temperature of the water at the insertion points of the fine channels to the collector —understood as the mean of the temperature of the insertion area, area which belongs to both the fine channel and the channel of the “collector” providing/receiving the water to/from the fine channel—was small, at least for a significant number of insertion points compared to the gradient between the insertion points of the fine channel to the “inlet” collector compared to the “outlet” collector at least for a significant number of fine channels—in most cases the fine channels or capillary-channels had only two insertion points, generally at both ends, but in some cases the fine channels were branched having more than two insertion points**). Configurations with only 1 main channel to configurations with almost 40 main channels were tested—Again the configuration refers to either the “inlet” or the “outlet” although both might have the same configuration, for example an “inlet”-system with just one main channel and an “outlet”-system with 12 main channels or a configuration where both the “inlet”-system and the “outlet”-system have just one main channel-. Configurations with no secondary channels, just one secondary level or secondary channels up to more than ten levels (tertiary, quaternary, . . . ) were tested. Configurations with no branching to configurations with almost 20 branches were tested—branching is understood without rang loss one main channel into two main channels in comparison to two secondary channels departing from a main channel.

Configurations with no secondary channels, with 2 secondary channels connected to a main channel to configurations with more than 100 secondary channels connected to a main channel were tested. Same thing with tertiary channels to secondary channels, quaternary channels to tertiary channels and so on and so forth. Configurations with only a few fine (capillary) channels to configurations with several hundredths of fine channels were tested. For certain configurations, a narrow range showed an improved performance, sometimes coinciding with other particular choosing of variables, as an example from the hundredths implemented: within 1 to 10 main channels for the “inlet”-system of channels and also the “outlet”-system, configurations with no branches and up to 4 branches, configurations with no secondary channels up to configurations with quaternary channels and configurations with no secondary (tertiary or quaternary) channels, only 2 secondary (tertiary or quaternary) channels in one given main channel up to 20 channels with 10 to 200 fine (capillary) channels—as can be seen in FIG. 1—presented good results but also varying depending on the values of other variables. Main channels with different profiles were tested, from cylindrical to squared with rounded edges, inverse droplet, elliptical, etc with many different equivalent diameters (most cases from 3.8 mm to almost 350 mm, several cases were between 11 mm and 57 mm), different cross sections (most cases from 9 mm2 to even more than 90000 mm2, several cases were between 126 mm2 and 2550 mm2). Both main channels, secondary channels and fine channels with constant and non-constant cross-sections were tested. In most configurations rather small distances from the fine channels to the working surface or surface to be thermo-regulated were preferred (in most cases distances between 0.6 mm and 32 mm were tested, several cases had distances between 1.2 mm and 18 mm). For the secondary (tertiary or quaternary) channels cross-sections between 3.8 mm2 and 122 mm2 were tested in most cases, with several configurations having cross-sections between 6.6 mm2 and 82 mm2. The mean cross-sectional area of the main channels was in most examples at least 3 times larger than that of the fine channels, in several cases more than 6 times larger and in some cases even more than 100 times larger. Very particular attention was placed into thoroughly testing of different fine channel configurations. Fine channels with different profiles were tested, from cylindrical to square with rounded edges, inverse droplet, elliptical, etc with many different equivalent diameters (most cases from 0.1 mm to almost 128 mm, several cases were between 1.2 mm and 18 mm, some cases between 1.2 mm and 8 mm), different cross sections (most cases from 0.008 mm2 to even more than 12000 mm2, several cases were between 1.13 mm2 and 50 mm2), separation from each other (most cases from 0.2 mm to almost 20 mm, several cases were between 1.2 mm and 9 mm), number of fine channels per square meter of thermo-regulated surface (most cases had 21 to more than 10.000, several cases had between 61 and 4000), H-value (most cases had from 12 to more than 1000, several cases had 12 to 230), surface density of fine channels (most cases had from 12% to more than 80%, several cases had 27% to 47%), mean length of the fine channels (most cases had between 0.6 mm and more than 500 mm, several cases had between 12 mm and 180 mm), pressure drop (most cases had between 0.01 bar and 5.9 bar, several cases had between 0.2 bar and 2.8 bar), rugosity (most cases had between 0.9 microns and more than 190 microns, several cases had between 10.2 microns and 98 microns). For certain configurations, a narrow range showed an improved performance on the cooling performance, sometimes coinciding with other particular choosing of variables, as an example from the hundredths implemented: fine channels with a square section with rounded edges, with mean distance to the surface between 2.6 mm and 8 mm, with the mean cross-section being more than 6 times smaller than that of the largest main channel, with a mean equivalent diameter between 1.2 mm and 8 mm and with a separation from each other between 1.2 mm and 9 mm, with a number of fine channels per square meter of thermo-regulated surface between 1100 and 4000, H-value between 12 to 230, with a mean length of the fine channels between 21 mm and 180 mm, a rugosity of the fine channels between 10.2 microns and 98 microns and a pressure drop between 0.2 bar and 2.8 bar—as can be seen in FIG. 1—, presented good results but also varying depending on the values of other variables.

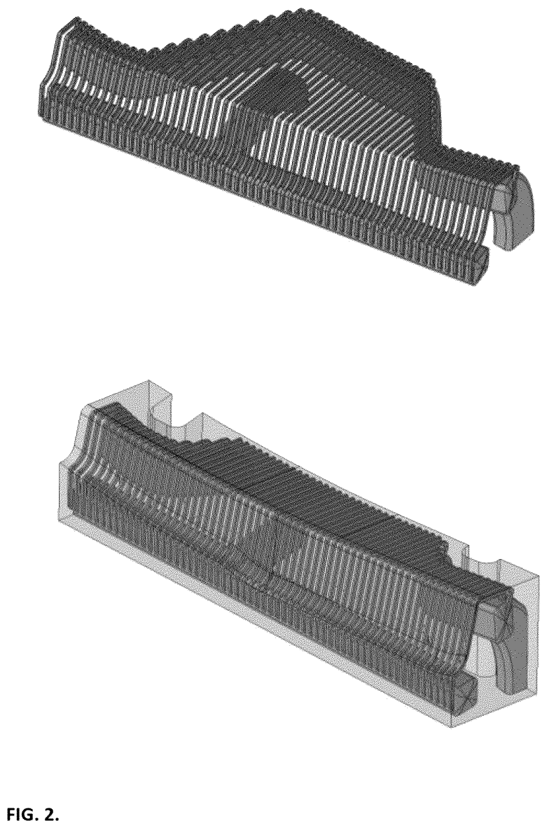

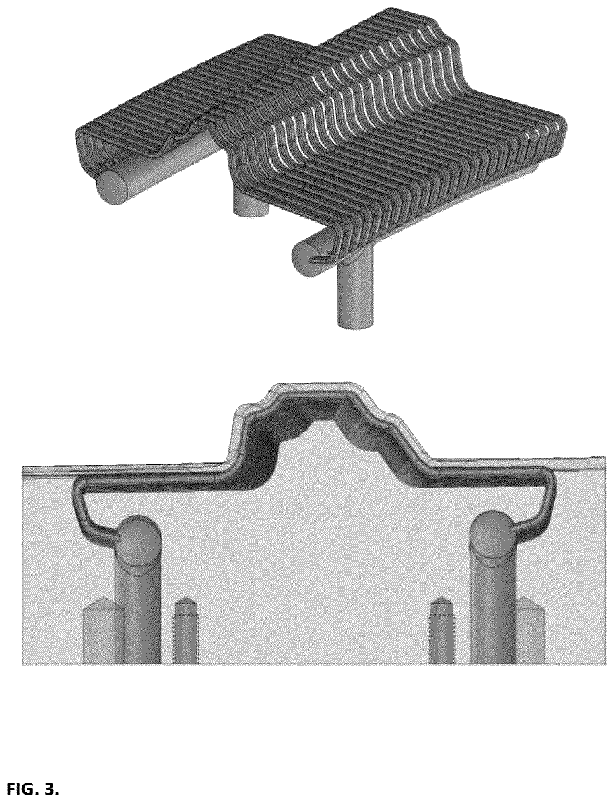

The manufactured dies and components were tested in all cases to ensure an adequate cooling. Test conditions were designed to ensure that the fluid flowed in the fine channels in such a way that the mean Reynolds number was maintained between 810 and 89000 in most cases, in many cases between 2800 and 26000, and in several cases between 4200 and 14000 with fluid velocities between 0.7 m/s and 14 m/s in most cases (in many cases between 1.6 m/s and 9 m/s while the minimum Reynolds number was maintained preferably between 810 and 14000). In some cases at least some of the main channels and/or secondary (tertiary, quaternary, . . . ) channels acted as collectors with fine channels connecting the inlet collectors to the outlet collectors. Thermal gradients within at least some collectors were maintained in most cases between 0.09° C. and 39° C., in several cases between 0.4° C. and 9° C. and in some cases between 0.4° C. and 4° C. In most cases at least 50% of the fine channels presented a temperature gradient between the two insertion points of the fine channels to the collectors for which the gradient was greatest between 1.1° C. and 199° C., in several cases it was more than a 20% of the fine channels which presented a thermal gradient between 2.6° C. and 48° C., and in some cases it was more than a 12% of the fine channels that presented a thermal gradient between 2.6° C. and 14° C. In most cases there were between 2 to several thousand fine channels between collectors, in any cases between 12 and 390, and in several cases between 22 and 140. Certain differences on the cooling efficiency were found, mainly dependent on the selected configurations, but without compromising the performance. For certain configurations, a narrow range showed an improved performance on the cooling performance, sometimes coinciding with other particular choosing of variables, as an example from the hundredths implemented: testing conditions designed in a way that the Reynolds number was between 4200 and 14000 for the fine channels with inlet and outlet collectors made of only main channels or main and secondary channels with a temperature gradient within the collectors at the insertion points of the fine channels between 0.4° C. and 0.9° C. and with at least 80% of the 22 to 140 fine channels between collectors presenting a temperature gradient between two insertion points to the collectors between 2.6° C. and 14° C.—as can be seen in FIG. 2—, presented good cooling performance results but also varying depending on the values of other variables.

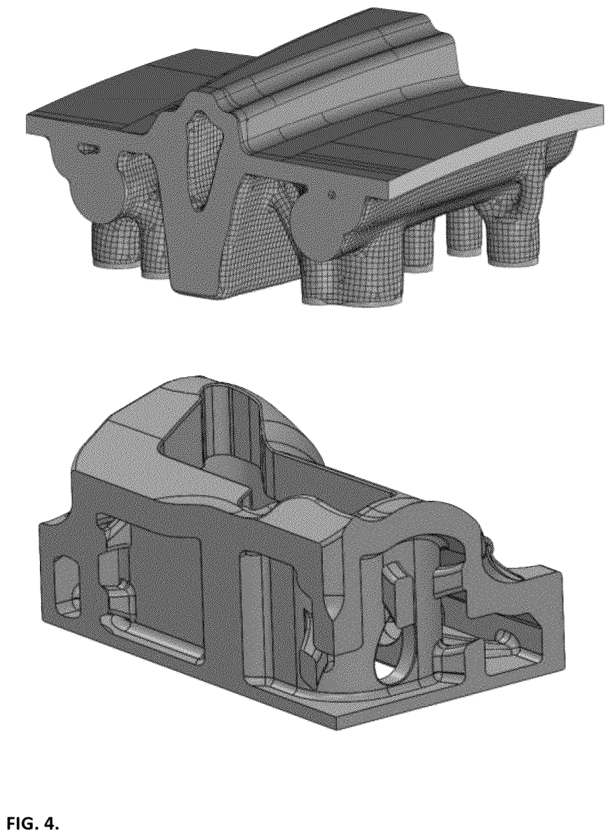

Example 6. Several light and large dies and other light and large components were manufactured using additive manufacturing methods comprising an organic material and comprising as well a metallic material in particulate form (technologies based on material extrusion like FDM/FFF; technologies based on vat photopolymerization like SLA, DLP, DLP projecting holograms and should also have worked with DLS—Digital Light Synthesis—or similar technologies based on CLIP—Continuous Liquid Interface Production, continuous digital light processing (CDLP), —; technologies based on bed fusion—PBF— like SLS, SHS—Selective Heat Sintering —; technologies based on material jetting like MJ, DOD; technologies based on binder jetting like BJ, MJF: and even technologies based on direct energy deposition—DED—; also some heads with some of the technologies mentioned in this paragraph were mounted on very large printers for BAAM) while it was possible to achieve satisfactory results with all of these technologies, several provided good results and a few provided exceptional results. Some of these light and large dies and other light and large components were manufactured using the strategies of examples 3, 4 and 6, while it was possible to achieve satisfactory results with all of this manufacturing strategies, several provided good results and a few provided exceptional results. The organic materials described in this document were used, amongst many others the materials described in examples 1, 2, 3, 4, 9, 11 and 12 to 15 were tested, while it was possible to achieve satisfactory results with all of these organic materials, several provided good results and a few provided exceptional results. The metal comprising materials described in this document were used, amongst many others the materials described in examples 1, 3, 4, 11 to 15, and 16 to 30 were tested, while it was possible to achieve satisfactory results with all of these metal comprising materials, several provided good results and a few provided exceptional results. Certain particular advantages were found depending on the technology and materials used, but the performance was ensured regardless of the technology and materials employed. Some examples can be seen in FIG. 4 upper image and the 3 upper segments of FIG.—6.

Several light large dies and other light and large components were manufactured using additive manufacturing methods comprising a metallic material in particulate or wire form (technologies based on bed fusion—PBF— like DMLS, SLM, EBM, and even SLS; technologies based on direct energy deposition DED—, in this case several technologies based on different welding principles were also tested; Joule printing was also tested; also some heads with some of the technologies mentioned in this paragraph were mounted on very large printers for BAAM), while it was possible to achieve satisfactory results with all of these technologies, several provided good results and a few provided exceptional results. Some of these light and large dies and other light and large components were manufactured using the strategies of example 31, while it was possible to achieve satisfactory results with all of these strategies, several provided good results and a few provided exceptional results. The metal comprising materials described in this document were used, amongst many others the materials described in examples 1, 3, 4, 11 to 15 and 16 to 30 were tested, while it was possible to achieve satisfactory results with all of these metal comprising materials, several provided good results and a few provided exceptional results. Certain particular advantages were found depending on the technology and materials used, but the performance was ensured regardless of the technology and materials employed. Some examples can be seen in FIG. 4 upper image and the 3 bottom segments of FIG.—6.

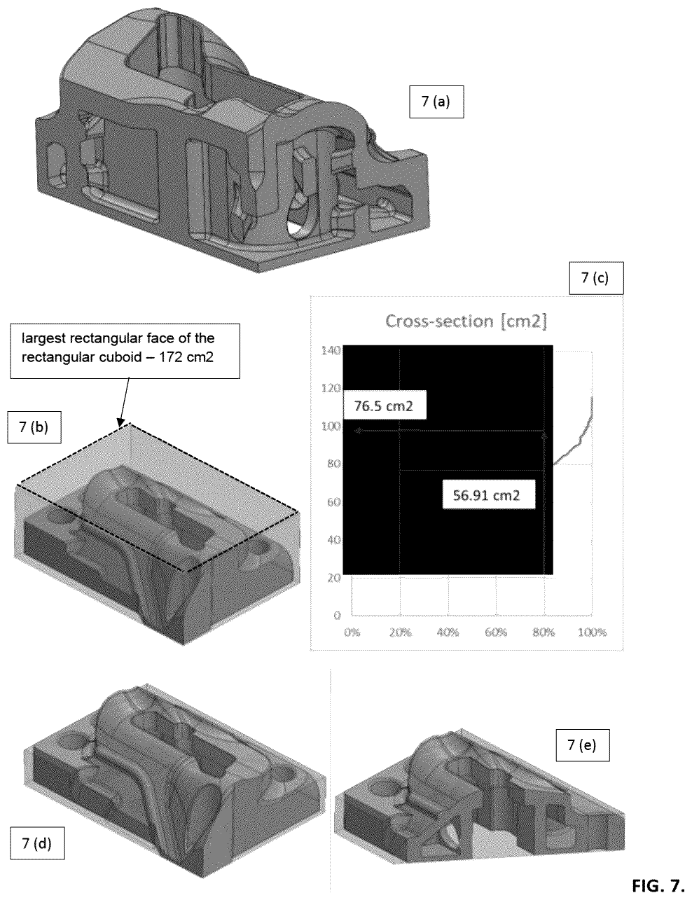

Several light large dies and other light and large components were manufactured using additive manufactured molds filled with metallic materials in particulate form. The molds were manufactured as described in this document, the cases described in examples 1, 11 and 13 to 15 were also tested (in some tests, the molds were manufactured using several technologies: FDM, FFF; SLA, DLP, DLP projecting holograms, DLS based on CLIP, CDLP, SLS, SHS, MJ, DOD; BJ, MJF; DED—; BAAM with a print head similar to FDM, FFF or even DED), while it was possible to achieve satisfactory results with all of these technologies, several provided good results and a few provided exceptional results. The organic materials mentioned in this document were used to manufacture the molds, amongst them the materials included in examples 1, 2, 3, 4, 9, 11, and 12 to 15, while it was possible to achieve satisfactory results with all of these organic materials, several provided good results and a few provided exceptional results. The metal comprising materials described in this document were used to fill the molds, amongst them those included in examples 1, 3, 4, 11 to 15 and 16 to 30, while it was possible to achieve satisfactory results with all of these metal comprising materials, several provided good results and a few provided exceptional results. The manufacture of the dies and other components was performed according to the manufacturing steps described in this document, aa the ones mentioned in examples 11 to 15, 8, 19 and 9 were also tested. Certain particular advantages were found depending on the technology and materials used, but the performance was ensured regardless of the technology and materials employed. Some examples can be seen in FIG. 4 lower image, FIG. 5 and in the 3 middle segments of FIG. 6. Some of the molds were constructed by assembling together different pieces manufactured as described above and joined as can be seen in FIG. 7. Some were only assembled together, some were joined with a joining media (glue, cyanoacrylate, . . . ), some were joined by melting the organic material of the AM parts at the joining edges (with resistive heat, hot-tip, hot air blowing, etc.) in some cases also material was brought into the “melt” or directly another material was molten on top of the AM pieces edges to be joined (PP, PCL, and many other were tested).

The component which lays above in FIG. 4 was manufactured both with using additive manufacturing methods comprising an organic material and comprising as well a metallic material in particulate form and using additive manufacturing methods comprising a metallic material in particulate or wire form.

Some of these light large dies and other light and large components comprised cooling channels, and some comprised cooling channels following the design strategies provided in this document which showed considerably improved thermoregulatory capabilities. Some of these large light dies and other light and large components comprising cooling channels were manufactured using the strategies of example 5, while it was possible to achieve satisfactory thermo regulation results with all of this strategies, many provided very good results and several provided exceptional results. Some examples can be seen in FIG. 5 and in FIG. 6.

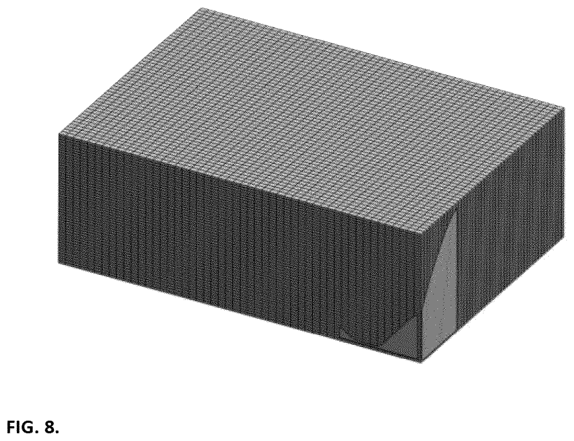

Several of the components and dies manufactured comprised voids as can be seen in FIG. 4 to FIG. 7. In some of those tests particular attention was placed on the amount and morphology of voids, the significant cross-sections, the significant thickness and/or the volume of the component in relation to the minimum rectangular cuboid comprising the component. (In FIG. 8 the concepts of Rectangular Cuboid, largest rectangular face of the rectangular cuboid, cross-section percentile and cuboid shaped with the working surface of the component are depicted). In example 7 a detailed way on how to calculate the values for those and other relevant geometrical variables can be found for the component depicted in FIG. 8. For the sake of limited extension the values used for the relevant geometrical variables regarding geometrical aspects will not be enumerated here because they fully coincide with the ones summarized for the different tests and reported in Example 7, with the sole exceptions of significant cross-sections and cross-section of the component, where both share upper boundaries with Example 7 but in the current example only cross-sections with more than 20 mm2 were used, as well as the significant thickness and the thickness of the component, where both share upper boundaries with Example 7 but in the current example only thicknesses above 12 mm were used (with a couple exceptions with thicknesses smaller than 12 mm even up to 1.2 mm).

Several large components were made of smaller parts which were joined together. Parts made as mentioned were joined together and in some cases also joined together with conventional manufactured parts. From 2 parts to more than 30 parts were joined together in different tests. An example can be seen in FIG. 6, with 3 parts manufactured using additive manufactured molds filled with metallic materials in particulate for, 3 parts manufactured using additive manufacturing methods comprising a metallic material in particulate or wire form and 3 parts using additive manufacturing methods comprising an organic material and comprising as well a metallic material in particulate form. Often the surfaces to be joined together or at least part of them were specially prepared, by means of oxide removal, dust removal, organic material removal, etc. In some tests, a lot of attention was placed into the weld recess or groove design adapting it to the technology used to make the outside temporary joining to ensure the join was pulling the surfaces together in most of the cases with more than 0.01 MPa, in several cases with more than 0.12 MPa and in some cases with even more than 5.12 MPa. In most tests, different joining techniques were used for the envelope joining, most could be considered welding techniques with different heat sources (plasma-arc, electric-arc, laser, electron-beam, oxy-fuel, resistive, induction, ultrasound, . . . ) for some low melting temperature materials even high temperature glue was tested. Quite often the joining was performed in a vacuum environment with vacuum levels from 900 mbar to even 10−7 mbar. In some tests the joining was performed in an oxygen free environment with levels most of the times ranging from 9% to less than 1 ppm, often the level was below 90 ppm. In some tests, the parts to be joined together had guiding mechanisms for an accurate placement within each other. In many tests the welding was done after the consolidation step and prior to the densification step, in some tests the welding or joining was made prior to the consolidation step. Often particular care was taken to make the welding lines or applied joining in a way to assure the surfaces to be joined together were gas tight. To test this extend some test components were submerged in a liquid and pressurized to pressures around 58 MPa, often above 152 MPa, several times around 220 MPa, sometimes around 300 MPa and even in a couple occasions above 555 MPa and then they were dried and checked (sometimes destructively) for liquid infiltration in the surfaces to be joined, after a short learning stage the welds were always gas tight. In several cases, special attention was placed on attaining a shallow critical welding depth, in most of these cases below 19 mm, in several cases below 3.8 mm and in some case below 0.4 mm. In such cases, and in others as well, special care was placed on the power density employed, in most of these cases it was kept below 900 W/mm3, in several cases below 90 W/mm3 and in some cases even below 0.9 W/mm3. In most of the tests, special care was taken to assure diffusion welding in the surfaces to be joined during the High temperature high pressure treatment. In some tests, special care was taken to assure diffusion welding in the surfaces to be joined during the consolidation step. Quite often the welding line was partially removed and in several occasions it was completely removed in one of the last machining steps. Many combinations of setups as described in this document were used for the High temperature high pressure treatment amongst them those described in examples 10 and 14.

Example 7. Several components with voids were manufactured with the different manufacturing technologies and materials of the present document. In FIG. 4 and FIG. 5 some such examples have been depicted. In all examples presented in this document more than one component with voids was manufactured (for examples 1, 3, 4, 5, 6, 8, 31 and 11 to 15 more than 20 components with voids in each case were manufactured). In this example, the main variables for all those tests are summarized and also for the purpose of illustration calculated in detail for the example depicted in FIG. 8.

In FIG. 8 the concepts of Rectangular Cuboid, largest rectangular face of the rectangular cuboid, cross-section percentile and cuboid shaped with the working surface of the component are depicted.

The example depicted in FIG. 8 is a die, in particular a cold work drawing and cutting die.

In the tests summarized in this example, the volume percentages of the rectangular cuboid that were void almost always were between 52% and 99%, in most cases between 62% and 94%, in several cases between 76% and 89% and in some cases above 92% and even above 96%.

In the tests summarized in this example, the volume of the component was almost always between 2% and 89% of the volume of the rectangular cuboid. In most cases it was between 6% and 74%, in many cases between 12% and 68%, in several cases less than 49%, in some cases less than 39% and even less than 19%, in several cases more than 22%, in some cases more than 44% and even more than 55%.

In the tests summarized in this example, the volume of the component was almost always between 2% and 89% k of the volume of the cuboid shaped with the working surface of the component. In most cases it was between 6% and 74%, in many cases between 12% and 68%, in several cases less than 49%, in some cases less than 39% and even less than 19%, in several cases more than 22%, in some cases more than 44% and even more than 55%.

In the example depicted in FIG. 8, the rectangular cuboid (b) has a volume of 84961 cm3, the cuboid shaped with the working surface of the component (d) and (e) has a volume of 54156 cm3, the component has a volume of 19022 cm3 so that the voids in the rectangular cuboid add up to 84961-19022=65939 cm3. Therefore the volume percentage of the rectangular cuboid that is void is 77.61%. The volume of the component is 22.39% of the volume of the rectangular cuboid. The volume of the component is 35.12% of the volume of the cuboid shaped with the working surface of the component.

In many of the tests summarized in this example, at least some of the voids were interconnected. In most cases from 2 to 10000 voids were interconnected. In several cases, from 11 to 4000 voids were interconnected. In most cases the percentage of interconnected voids was between 6% and 99%, in many cases between 12% and 96%, in several cases between 26% and 84%, in some cases between 46% and 79%, in a few cases above 56% and even above 91%, in a few cases below 54% and even below 44%. In most of the examples some of the voids were connected to the outside of the component.

In most cases the percentage of voids connected to the outside of the component was between 6% and 99%, in many cases between 11% and 94%, in several cases between 21% and 89%, in some cases between 41% and 74%, in a few cases above 76% and even above 91%, in a few cases below 64% and even below 49%.

For certain configurations, a narrow range showed an improved performance, sometimes coinciding with other particular choosing of variables, as an example from the hundredths implemented: volume percentages of the rectangular cuboid that were void between 62% and 89%, with the volume of the component between 12% and 68% of the volume of the cuboid shaped with the working surface of the component, with more than 2 voids interconnected, with at least 6% of the voids interconnected and at least 11% of the voids connected to the outside of the component, with the significant cross-section of the component being less than 0.69 times the area of the largest rectangular face of the rectangular cuboid presented good performance results but also varying depending on the values of other variables.

In the tests summarized in this example, the significant cross-section of the component was almost always 0.79 times or less the area of the largest rectangular face of the rectangular cuboid, in most cases 0.69 times or less, in many cases 0.59 times or less, in several cases 0.49 times or less, in some cases 0.39 times or less, in a few cases 0.19 times or less and even 0.0009 times or less. Since different definitions of cross-section are more interesting for different applications, in this case all definitions were evaluated.

In the example depicted in FIG. 8(c) the mean cross-section obtained when the 20% of the largest cross-sections and the 20% of the lowest cross-sections are not considered amounts to 56.91 cm2. The cross-section at the 80th percentile amounts to 76.5 cm2 as can be seen in FIG. 8(c). The largest rectangular face of the rectangular cuboid as depicted in FIG. 8(b) amounts to 172 cm2. In the applications, where the significant cross section is best match with a particular percentile, the plot in FIG. 8(c) would be used, in particular for the 80th percentile, the significant cross-section of the component is 0.44 or 44% of the area of the largest rectangular face of the rectangular cuboid. In the applications —like is the case in the example depicted in FIG. 8—, where the significant cross-section is best match with the mean cross-section when 20% of the largest cross-sections and the 20% of the smallest cross-sections are not considered, the plot in FIG. 8(c) would be used to calculate that the significant cross-section of the component is 0.33 (=56.91/172) or 33% of the area of the largest rectangular face of the rectangular cuboid.

In order to evaluate the different relevant geometrical variables in an automatized way, the concept of“voxel” proves very efficient. In the tests summarized in this example all the possible definitions of “voxels” described in this document were tested (all geometries of voxel, all edge lengths, all ways to evaluate a geometrical variable with respect of the existing voxels, n values, etc).

In the tests summarized in this example, both the significant cross-section of the component and the cross-section of the component were almost always between 0.2 mm2 and 2900000 mm2, in most cases between 2 mm2 and 900000 mm2, in many cases between 20 mm2 and 90000 mm2, in several cases between 200 mm2 and 29000 mm2, in some cases between 2000 mm2 and 40000 mm2, in a few cases below 9000 mm2 and even below 4900 mm2. In some tests, many of those where bio-mimetic designs were applied, had very small values of both the significant cross-section of the component and the cross-section of the component which were almost always below 2400 mm2, in most cases below 900 mm2, in many cases below 400 mm2, in several cases below 190 mm2, in some cases below 90 mm2 and in a few cases below mm2.

In the tests summarized in this example, both the significant thickness of the component and the thickness of the component were almost always between 0.12 mm and 1900 mm, in most cases between 1.2 mm and 900 mm, in many cases between 12 mm and 580 mm, in several cases between 22 mm and 380 mm, in some cases above 112 mm, in some cases below 180 mm, in a few cases below 80 mm and even below 40 mm. In some tests, many of those where bio-mimetic designs were applied, had very small values of both the significant thickness of the component and the thickness of the component which were often below 19 mm, sometimes below 9 mm and even below 0.9 mm.

In the example depicted in FIG. 8 the significant thickness of the component obtained as the largest thickness of the component after excluding 30% of the largest thicknesses and evaluated with voxels using a n=19100 was 56.4 mm. The significant thickness of the component obtained as the largest thickness of the component below the 60th percentile and evaluated with voxels using a n=1060 was 49.2 mm.

For certain configurations, a narrow range showed an improved performance, sometimes coinciding with other particular choosing of variables, as an example from the hundredths implemented: significant cross-section of the component 0.69 times or less the area of the largest rectangular face of the rectangular cuboid, significant cross-section of the component between 2 mm2 and 29000 mm2 evaluated as the mean cross-section obtained when the 20% of the largest cross-sections and the 20% of the lowest cross-sections are not considered, significant thickness of the component between 1.2 mm and 900 mm evaluated as the largest thickness of the component below the 70th percentile and evaluated with voxels using a n=41000, presented good performance results but also varying depending on the values of other variables.

Example 8. Many tests were done to fine tune the Pressure and/or Temperature treatment, for those applications benefiting from such treatment. All configurations mentioned in the present document were tested. Amongst them, all configurations tested in examples 1, 3, 4, 5, 6, 7, 9, 10, 11 to 15, and 31. In all those cases, at least one test was performed—with each configuration— with the Pressure and/or Temperature treatment performed before the debinding and at least one test was performed—with each configuration— with the Pressure and/or Temperature treatment performed after the debinding. Each configuration of the Pressure and/or Temperature treatment tested was at leas tested in an environment of “homogeneous pressure application”. That includes also all tests performed in examples 12 to 15. All materials described in examples 1, 3, 4, 11 to 15 and 16 to 30 were tested.

In one first configuration an homogeneous fluid was used to apply the pressure, this fluid was often the blending of different fluids or even fluids comprising solid particles but rather homogeneously mixed. While the viscosity level of the fluid proved to be very important for many of the tests it was surprising to see that some tests run much better with high viscosity levels for the fluid transmitting the pressure, while other tests run better with low viscosity levels for the fluid transmitting the pressure, and even some tests showed no relevance of the viscosity level.

For the pressure transmitting fluid, for almost all cases the viscosity was between 1.1 cSt and 490000000 cSt, for most cases between 6 cSt and 49000000 cSt, for many cases between 26 cSt and 9000000 cSt, for several cases between 106 cSt and 940000 cSt, for some cases above 255 cSt and even above 1006 cSt.

The cases which clearly benefited from a high viscosity level on the pressure transmitting fluid, in several of this cases it was also interesting for the fluid to be hydrophobic. For those tests, in almost all cases the viscosity was between 1006 cSt and 490000000 cSt, in most cases between 10016 cSt and 94000000 cSt, in many cases between 100026 cSt and 49000000 cSt, in several cases above 1006000 cSt, in some cases above 11001000 cSt and even above 200001000 cSt. In such cases many different type of fluids were tested, to mention some: oils (mineral, vegetable, natural, . . . ), silicon-based materials, silicon fluids, fluids with at least one siloxane functional group, polydimethylsiloxanes, linear polydimethylsiloxane fluids, fluids with at least one olefin functional group, fluids with at least one alphaolefin functional group, polyalphaolefin (PAO), metallocene polyalphaolefin (mPAO), silicone oils, perfluorinated oils, perfluorinated polyether oils (PFPE). Also in some cases some solid lubricants were used as thickeners: like lithium base and PFPE solid lubricants amongst others. In several tests the “fluid” to apply the pressure was in fact a grease, so the concept of “fluid” has to be extended also to greases for the “fluid” to apply the pressure. Animal greases or fats were tested but while they provided good results in many cases the odor was very disagreeable. Some examples of industrial greases used: greases which comprising a perfluorinated polyether oil (PFPE), greases comprising silicone oils, greases comprising perfluorinated polyether solid lubricants, greases comprising lithium-base solid lubricants. In the case of greases often NLGI indexes were also used because it was easier to communicate with the manufacturer, greases with the following NLGI indexes were tested: 000, 00, 0, 1, 2, 3, 4 and 4+(which kind of encompassed anything above 4).

Kinematic viscosities were measured at RT, 40° C. and 100° C. The ones reported in this example are the ones at RT.

The cases which clearly benefited from a lower viscosity on the pressure transmitting fluid quite often seemed to work better when the components were encapsulated (like with a vacuum bag, a conformal elastomeric coating, etc.) and in the case of molds filled with metallic powders it was better to play specially good attention at the closure of the lids. For those tests, in almost all cases the viscosity was between 1.1 cSt and 440000 cSt, in most cases the viscosity was above 6 cSt, in many cases above 26 cSt, in several cases above 10⁶ cSt and in some cases above 255 cSt. In a few cases higher viscosities were used, leading to 1006 cSt or more, in some cases the viscosity was below 990 cSt. The fluids used in those cases were several, to mention a few: water, water solutions (like ethylene glycol, propylene glycol, etc), oils (mineral, vegetable, natural, . . . ), fluids with at least one olefin functional group, fluids with at least one alphaolefin functional group, polyalphaolefin (PAO), metallocene polyalphaolefin (mPAO), silicone oils, perfluorinated oils, perfluorinated polyether oils (PFPE), hydrocarbons, aromatic hydrocarbons, aliphatic hydrocarbons.

In several tests it was observed that the dielectric loss and the dielectric constant of the pressure transmitting fluid were of capital importance—including those carried out in examples 2, 9 and 10-For those tests were the dielectric loss was important, in almost all cases values were between 0.006 and 3.99, in most cases between 0.011 and 1.99, in many cases between 0.011 and 1.49, in some cases above 0.051 and even above 0.12, in some cases below 0.97, in a few cases below 0.09 and even below 0.009. For those tests were the dielectric constant was important, in almost all cases values were between 1.1 and 48, in most cases between 1.6 and 18, in several cases below 9 and even below 3.9, in several cases above 2.1 and even above 2.6. In most cases dielectric constant and dielectric loss were evaluated at 2.45 GHz. In some cases, dielectric constant and dielectric loss were evaluated at 0.915 GHz.

In some of the tests it was observed that the degradation temperature of the pressure transmitting fluid was important—including those carried out in examples 1, 5, 6, 7, and 11 to 15-. For those tests were the degradation temperature was important, in almost all cases values were between 56° C. and 588° C., in most cases between 92° C. and 498° C., in many cases between 156° C. and 387° C., in some cases between 206° C. and 297° C.

while it was possible to achieve satisfactory results with all of these technologies, several provided good results and a few provided exceptional results in terms of final densification of the components, with many approaching or even reaching full density, and others reaching the desired density level but accompanied with exceptional toughness related properties.

For certain configurations, a narrow range showed an improved performance, sometimes coinciding with other particular choosing of variables, as an example from the hundredths implemented: homogeneous fluid to apply the pressure based on a fluid with at least one olefin functional group, with a viscosity between 6 cSt and 440000 cSt, a dielectric constant between 1.6 and 18, a degradation temperature between 206° C. and 297° C.—Like Expectrasyn plus an mPAO with 15.4 cSt, 2.09 and 248° C.—, presented good performance results but also varying depending on the values of other variables. Or another example amongst the ones with high viscosity with an homogeneous fluid to apply the pressure based on a silicon-based fluid with at least one siloxane functional group, with a viscosity between 10016 cSt and 49000000 cSt, a dielectric loss between 0.011 and 1.99 a dielectric constant between 1.1 and 48, a degradation temperature between 156° C. and 387° C.—Like clearco a pure silicone with 20,000,000 cSt, 0.1, 2.75 and 321° C.—, presented good performance results but also varying depending on the values of other variables.

In a second configuration, at least two different fluids were used to apply the pressure and they were clearly segregated, the two different fluid natures could be detected in different points in space. In some tests a pressure transmitting container was used to separate the different fluids.

As pressure transmitting container different materials were tested, amongst others materials comprising: elastomeric materials, hydrogenated nitrile (HNBR), polyacrylate (ACM), ethylene Acrylate (AEM), fluorosilicone (FVMQ), silicone (VMQ), fluorocarbon (FKM), TFE/propylene (FEPM), perfluorinated elastomers (FFKM), polytetrafluorethylene (PTFE), polyphenylene sulfide (PPS), polyether ether ketone (PEEK), polyimide (Pl), viton, ethylene-propylene-diene monomer rubber (EPDM), polymer, laminated polymer, at least two laminated to each other polymers, laminated polymer and a metal comprising foil, laminated polymer and a metallic foil, laminated polymer and a metallic foil joined trough lamination, laminated polymer and a metal comprising adhesive band, metallic foil. Amongst others as metallic foils Cu alloys, steel and aluminum alloys were tested.

In several tests it was made sure that the inner fluid in contact with the component had a higher kinematic viscosity than at least one of the other fluids. The difference was in most of the cases between 20 cSt and 89000000 cSt, in most cases between 206 cSt and 19000000 cSt, in many cases between 1020 cSt and 1900000 cSt, in some cases the difference was lower than 90000 cSt, in several cases the difference was bigger than 12000 cSt, in some cases bigger than 102000 cSt, in a few cases bigger than 890000 cSt and even bigger than 2200000 cSt.

In several cases, the pressure transmitting fluid was substituted by a fluidized bed, so in those tests the pressure was solely or at least partially applied by a fluidized bed. Several types of fluidized beds were tested, from solid particles, to solid particles softening or even completely melting during the Pressure and/or Temperature treatment to fluids containing solid particles. Different of particles were used for the fluidized bed from metals to ceramics to polymers. Amongst the metals, most of the powders available from examples 16 to 30 were tested. It was observed that for some tests the elastic limit of the balls had an influence, in almost all of the satisfactory cases where elastic limit was observed to have an influence were between 153 MPa and 4940 MPa, in most cases between 210 MPa and 3940 MPa, in many cases between 360 MPa and 2940 MPa, in several cases above 440 MPa, in some cases above 620 MPa, in a few cases above 1020 MPa and even above 2020 MPa. Some of the “metallic” particles comprised ceramics, they were metal matrix composites (MMC) like the ones obtained from example 30. In a few cases it was seen that low elastic limit metal comprising balls were preferably, although their recyclability was much more difficult, in almost all of the satisfactory cases where low elastic limit was observed to have an influence were between 16 MPa and 190 MPa, in most cases between 106 MPa and 140 MPa. In most of the cases, the balls had a size between 0.0016 mm and 98 mm, in many cases between 0.012 mm and 19 mm, in several cases below 9.4 mm, in some cases below 0.9 mm and even below 0.42 mm. In several tests, ceramic particles were employed (like fine ceramic powders, MgO powder, pyrophyllite powder, even fine common salt amongst others). In several tests polymeric particles were tested, here two different global strategies were tested: 1) at least partially melting polymer, in this case low melting point polymers were employed and they were allowed to melt—at least partially— or soften a lot during the Pressure and/or Temperature treatment, in most cases the melting or softening was allowed before the highest pressure was applied, in almost all cases the melting temperature of the polymer or polymer blend was between 26° C. and 249° C., in most cases between 57° C. and 194° C., in some cases above 103° C., in several cases below 123° C., in some cases below 93° C. and even below 59° C. —a few examples of such polymers used are PP, PCL, HIPS, PVA, PE, LDPE, HDPE, ABS, SAN, PMMA, PEVA, etc.—; 2) the polymer particules of the fluidized bed were not allowed to melt, in this tests almost always the polymer had a melting temperature above 110° C., in most cases above 170° C., in many cases above 220° C., in several cases above 310 AC and in a few cases above 350° C. —a few examples of such polymers used are PPS, PEEK, Pl, etc.—. Polymeric powders were in most tests between 26 and 143 microns, in some cases below 93 microns, in some cases below 68 microns and even below 44 microns. In some tests mixtures of different polymeric powders were used, also mixtures of polymeric powders with ceramic particles and/or metallic balls, also in some cases the particules were introduced in a fluid in those cases almost always the volume fraction of particules in the fluid was 3% or more, in most of the cases 6% or more, in many cases 11% or more, in several cases 16% or more and in some cases 36% or more.

while it was possible to achieve satisfactory results with all of these technologies, several provided good results and a few provided exceptional results.

For certain configurations, a narrow range showed an improved performance, sometimes coinciding with other particular choosing of variables, as a couple examples from the hundredths implemented: FKM pressure transmitting container with a silicone fluid as inner fluid with a kinematic viscosity above 100,000 cSt or even above 1,000,000 cSt with an outer fluid comprising a mineral oil with less than 1000 cSt, or a viton pressure transmitting container with a polyolefin powder as fluidized bed inside and a polypropylene glycol as outer pressure transmitting fluid, or a mPAO with around 1000 cSt with more than 36% maraging balls—size around 70 microns—with an elastic limit around 2200 MPa as inner pressure transmitting fluid a 0.8 mm thick copper foil as a pressure transmitting container and water as outer fluid, or a laminated Pl on copper foil as a pressure transmitting container with a pyrophyllite fine powder —less than 44 microns—as fluidized bed inside and a vegetal oil as pressure transmitting fluid outside, presented good performance results but also varying depending on the values of other variables.

Example 9. For the Pressure and/or Temperature treatment, many tests have been done with different configurations for high end applications. In some of these tests different heat sources were employed. Some very interesting results were obtained when using microwaves as a heat source. In some of those cases a correlation between % NMVS (in some instances % NMVC) and/or Apparent density and efficiency of the process was observed. In every instance where a Pressure and/or Temperature treatment was performed for any of the examples and or proofs of concept while developing the technology—which led to the present document—microwaves were tested as an alternative source (like for instance in examples 1, 3, 4, 5, 6, 7, 8, 12 to 15 and 31 in all of them with the materials from examples 16 to 30). In this example a summary of all those tests is provided.

In all tests the frequency 2.45 GHz was tested, in some tests further frequencies were tried like 0.915 GHz, 5.8 GHz, frequencies between 6 GHz and 19 GHz and even for a few tests 2.45 MHz. Several chambers were constructed for the tests, almost all of them being cylindrical in shape. The size of the chamber was very carefully chosen in some cases metal plates were used to alter the “effective” size and shape of the chamber in terms of resonance of the microwaves. Sometimes the plates were circular and acted as a lid shortening the “effective” length and in some other tests the metal plates were rather rectangular in shape and placed to form a particular 2efective” shape of the chamber, the geometry when looking with a birds-eye prospective (in the case of a cylindrical chamber, looking the cylindrical chamber from the top so that the chamber appears to be a circle) of the plates was different than a cylinder (several geometries were tested amongst which, polygon—so polygonal positioning of the plates-amongst them: hexagon—so hexahedral positioning of the plates-, heptagon—heptahedral-, octagon —octahedral-, dodecagon—dodecahedral-; and also triangle—triangular-), in almost all cases the placement was made in accordance to some of the first eigenvalues of the frequency tested. The chamber was highly pressurized for the tests almost all the tests were done at pressures between 620 bars and 8900 bars—which proved to be insufficient in some cases—, most tests between 1200 bars and 8900 bars, many above 2100 bars, some above 2600 bars, a few above 3010 bars and even above 3800 bars. The power employed for the tests was in almost all cases between 55 W and 55000 W, in most tests between 355 W and 19000 W, in many tests between 555 W and 9000 W, in several tests above 1055 W, in some tests above 3055 W, in a few tests below 3900 W and even below 900 W. For this different tests chambers with the corresponding pressure rating were employed.

Several solutions were tested in how to bring the microwaves into the pressurized chamber: 1—the whole magnetron was placed inside the chamber, often with a shielding plate to protect it from the microwaves, in this case a pressure resistant magnetron had to be build and also in this case a high power feed trough was provided to bring sufficient power in the right form in the chamber (in almost all cases high power feed troughs rated to powers between 1100 W and 44000 W were used, in most tests between 5600 W and 214000 W, in many cases between 10100 W and 169000 W, in several cases between 10100 W and 79000 W), in some instances more than one feed-trough was used. 2—The connection between the anode of the magnetron and the antenna is interrupted by the feed-trough, in this case high voltage feed-troughs were used (in almost all cases between 600 V and 190000 V rating, in most cases between 1200 V and 110000 V, in many cases between 2200 V and 49000 V also when it came to the apparent power in almost all cases between 1200 VA and 990000 VA rating, in most cases between 6200 VA and 190000 VA, in many cases between 11000 VA and 89000 VA). 3—The whole generator was left outside the pressurized chamber and the microwaves were introduced in the chamber trough a coaxial feed-trough, the applicator (or in many tests applicators) was then inside the chamber (in this case coaxial feed-troughs were used. In almost all cases the nominal outer diameter of the coaxial cable was between 7/32″ and 4- 1/16″, in most cases between 7/16″ and 3-⅛″, in many cases between ⅞″ and 3-⅛″ and in some cases equal or above 1-⅝″ and in some cases below 1-⅝″. In almost all cases the impedance was between 1.1 Ohms and 199 Ohms, in most cases between 21 Ohms and 150 Ohms, in several cases between 41 Ohms and 99 Ohms, in some cases between 41 Ohms and 69 Ohms, and in a few cases below 49 Ohms), in several tests the applicator was an antenna (as said some tests there was only one applicator and in some tests there were from 2 to 990 applicators—in most cases 2 to 90, in many 2 to 19, in several 4 to 14). In all 3 cases configurations with only one feed-trough were tested but also configurations with more than one feed-trough (in most tests between 2 and 19, in many between 2 and 9, in some between 4 and 14). In some tests configurations with only one magnetron were tested but also configurations with more than one magnetron (in most tests between 2 and 19, in many between 2 and 9, in some between 4 and 14). In some tests configurations with only one microwave generator were tested but also configurations with more than one microwave generator (in most tests between 2 and 19, in many between 2 and 9, in some between 4 and 14). When a microwave generator was employed, often it was connected to one or several coaxial feed-troughs in one of the walls or one of the lids of the pressurized chamber, and the applicator/s (often antennas) were connected to the high pressure side of the coaxial feed-trough. Amongst many kinds of feed-troughs tested many had a glass to provide the sealing. Amongst many kinds of feed-troughs tested many had a ceramic to provide the sealing. When a microwave generator was employed, often it was a solid state generator. In many of the tests, the pressurized chamber comprised a system capable of procuring movement so that the load being processed or tested could move, up and down, side to side and/or could rotate, in many cases the moving system comprised a pressurized fluid, in many cases the moving system comprised a motor which was often inside the chamber and also often shielded from the microwaves by means of a metal plate.

Some tests were also carried out with “glowing” materials or “glowing panels” in the same way as described in Example 10.

A lot of attention was placed on the dielectric constants and dielectric losses of at least some of the materials employed for the polymeric molds (when employed), pressure transmitting container (when employed), wrapping materials (when employed), bagging materials (when employed), and the fluids (or fluidized beds) employed to apply the pressure. In most of the cases dielectric losses between 0.006 and 3.99 were employed, in most tests between 0.011 and 1.99, in many tests between 0.051 and 0.97, in some tests above 0.12, in some cases below 0.09 and even below 0.009. In most of the cases the dielectric constant was between 1.1 and 1000, in most tests between 1.6 and 48, in many tests between 1.6 and 9, in several tests below 3.9, in some cases above 2.1 and even above 2.6. Sometimes kind of “glowing” materials were incorporated in the powder mix, the material of the mold, or a bagging or wrapping material or even in the pressure applying fluid.

while it was possible to achieve satisfactory results with all of these technologies, several provided good results and a few provided exceptional results. Certain particular advantages were found depending on the particular configurations used, but the performance was ensured regardless configuration employed. The high performance achieved with several of these configurations in terms of mechanical performance of the components manufactured was unmatched by existing traditional conventional and traditional-MAM manufactured components.

Example 10. For the High Temperature/High pressure or densification treatment, many tests have been done with different configurations for high end applications. In some of these tests different heat sources were employed. Some very interesting results were obtained when using microwaves as a heat source. In some of those cases a correlation between % NMVS (in some instances % NMVC) and/or Apparent Density (AD) and efficiency of the process was observed. In every instance where a High Temperature/High pressure or densification treatment was performed for any of the examples and or proofs of concept while developing the technology—which led to the present document—microwaves were tested as an alternative source (like for instance in examples 1, 3, 4, 5, 6, 7, 8, 9, 12 to 15 and 31 in all of them with the materials from examples 16 to 30). In this example a summary of all those tests is provided.

In all tests the frequency 2.45 GHz was tested, in some tests further frequencies were tried like 0.915 GHz, 5.8 GHz, frequencies between 6 GHz and 19 GHz and even for a few tests 2.45 MHz. Several chambers were constructed for the tests, almost all of them being cylindrical in shape. The size of the chamber was very carefully chosen in some cases metal plates were used to alter the “effective” size and shape of the chamber in terms of resonance of the microwaves. Some times the plates were circular and acted as a lid shortening the “effective” length and in some other tests the metal plates were rather rectangular in shape and placed to form a particular 2efective” shape of the chamber, the geometry when looking with a birds-eye perspective (in the case of a cylindrical chamber, looking the cylindrical chamber from the top so that the chamber appears to be a circle) of the plates was different than a cylinder (several geometries were tested amongst which, polygon—so polygonal positioning of the plates—amongst them: hexagon—so hexahedral positioning of the plates—, heptagon—heptahedral-, octagon—octahedral-, dodecagon —dodecahedral-; and also triangle—triangular-), in almost all cases the placement was made in accordance to some of the first eigenvalues of the frequency tested. The chamber was highly pressurized for the tests almost all the tests were done at pressures between 620 bars and 8900 bars—which proved to be insufficient in some cases—, most tests between 1200 bars and 8900 bars, many above 2100 bars, some above 2600 bars, a few above 3010 bars and even above 3800 bars. The power employed for the tests was in almost all cases between 55 W and 55000 W, in most tests between 355 W and 19000 W, in many tests between 555 W and 9000 W, in several tests above 1055 W, in some tests above 3055 W, in a few tests below 3900 W and even below 900 W. For this different tests chambers with the corresponding pressure rating were employed.

Several solutions were tested in how to bring the microwaves into the pressurized chamber: 1—the whole magnetron was placed inside the chamber, often with a shielding plate to protect it from the microwaves, in this case a pressure resistant magnetron had to be build and also in this case a high power feed trough was provided to bring sufficient power in the right form in the chamber (in almost all cases high power feed troughs rated to powers between 1100 W and 44000 W were used, in most tests between 5600 W and 214000 W, in many cases between 10100 W and 169000 W, in several cases between 10100 W and 79000 W), in some instances more than one feed-trough was used. 2—The connection between the anode of the magnetron and the antenna is interrupted by the feed-trough, in this case high voltage feed-troughs were used (in almost all cases between 600 V and 190000 V rating, in most cases between 1200 V and 110000 V, in many cases between 2200 V and 49000 V also when it came to the apparent power in almost all cases between 1200 VA and 990000 VA rating, in most cases between 6200 VA and 190000 VA, in many cases between 11000 VA and 89000 VA). 3—The whole generator was left outside the pressurized chamber and the microwaves were introduced in the chamber trough a coaxial feed-trough, the applicator (or in many tests applicators) was then inside the chamber (in this case coaxial feed-troughs were used. In almost all cases the nominal outer diameter of the coaxial cable was between 7/32″ and 4- 1/16″, in most cases between 7/16″ and 3-⅛″, in many cases between ⅞″ and 3-⅛″ and in some cases equal or above 1-⅝″ and in some cases below 1-⅝″. In almost all cases the impedance was between 1.1 Ohms and 199 Ohms, in most cases between 21 Ohms and 150 Ohms, in several cases between 41 Ohms and 99 Ohms, in some cases between 41 Ohms and 69 Ohms, and in a few cases below 49 Ohms), in several tests the applicator was an antenna (as said some tests there was only one applicator and in some tests there were from 2 to 990 applicators—in most cases 2 to 90, in many 2 to 19, in several 4 to 14). In all 3 cases configurations with only one feed-trough were tested but also configurations with more than one feed-trough (in most tests between 2 and 19, in many between 2 and 9, in some between 4 and 14). In some tests configurations with only one magnetron were tested but also configurations with more than one magnetron (in most tests between 2 and 19, in many between 2 and 9, in some between 4 and 14). In some tests configurations with only one microwave generator were tested but also configurations with more than one microwave generator (in most tests between 2 and 19, in many between 2 and 9, in some between 4 and 14). When a microwave generator was employed, often it was connected to one or several coaxial feed-troughs in one of the walls or one of the lids of the pressurized chamber, and the applicator/s (often antennas) were connected to the high pressure side of the coaxial feed-trough. Amongst many kinds of feed-troughs tested many had a glass to provide the sealing. Amongst many kinds of feed-troughs tested many had a ceramic to provide the sealing. When a microwave generator was employed, often it was a solid state generator. In many of the tests, the pressurized chamber comprised a system capable of procuring movement so that the load being processed or tested could move, up and down, side to side and/or could rotate, in many cases the moving system comprised a pressurized fluid, in many cases the moving system comprised a motor which was often inside the chamber and also often shielded from the microwaves by means of a metal plate. Sometimes the metal plate was polished.

When the components being processed had rather low values of % NMVS and % NMVC and/or high AD values—for AD sometimes values above 71%, more often when above 79.8%, even more often when above 86%, quite regularly when above 97% and even more so when above 99.1%; for both % NMVS and % NMVC sometimes values below 9%, more often when below 4%, even more often when below 1.2% and even more so when below 0.3%) it was sometimes challenging to heat up in a controlled way to the desired temperature. In such cases, the use of “glowing” materials and “glowing” panels was very helpful. In many tests the glowing materials heated up very fast when the microwaves were applied. Several “glowing” materials were tested (amongst others: several alloys, several metal comprising alloys—amongst others molybdenum based alloys, tungsten based alloys, tantalum based alloys, zirconium based alloys, nickel based alloys, iron based alloys, etc.—many materials with a high dielectric loss at the frequency used for the test—in most of the cases between 10.49 and 199 @ 2.45 GHz, in many cases between 20.97 and 99 @ 2.45 GHz —, amongst such materials ceramic materials—like carbides *p. e. TiC*, borides *p. e. TiB2*, titanates *p. e. (Ba, Sr (TiO3)), etc.), the “glowing” materials were often used in powder form, and sometimes sprayed and/or projected onto a support material, many other bonding methods for the “glowing” materials were also tested. Several shapes for the elements supporting the glowing materials were tested: Squared, rectangular, spherical, conical, cylindrical, polygonal, irregular, etc. In some tests the microwave applicator, antenna and/or parts of a magnetron and/or microwave generator were inside the element supporting the “glowing” materials. Many materials were tested for the elements supporting the “glowing” materials—metal sheets, alloys, metal comprising alloys, molybdenum based alloys, tungsten based alloys, tantalum based alloys, zirconium based alloys, nickel based alloys, iron based alloys, ceramics, etc.—Often a radiation shield was placed between the element supporting the “glowing” materials and the pressurized chamber to lower the temperature exposure and stop certain prejudicial radiation. In many cases one shield was sufficient but in many other cases more than one was better—often between 2 and 49, in some cases between 2 and 19, in a few cases between 4 and 9-. As materials for the radiation shields, which were sometimes polished, many were tested —amongst others alloys, metal comprising alloys, molybdenum based alloys, tungsten based alloys, tantalum based alloys, zirconium based alloys, etc.—. Often the radiation shields were concentrically disposed with respect of each other and often concentrically about the vertical axis (or axis shared or parallel to the one of the element supporting the “glowing” materials which often was in turn parallel to that of the pressurized chamber). Different radiation shield geometries were tested, often coinciding with the geometry of the element supporting the “glowing” materials, although they were sometimes different in size.—amongst others: cylindrical, Squared, rectangular, spherical, conical, polygonal, irregular, etc-.

While it was possible to achieve satisfactory results with all of these configurations, several provided good results and a few provided exceptional results.

Certain particular advantages were found depending on the particular configurations used, but the performance was ensured regardless configuration employed. The high performance achieved with several of these configurations in terms of mechanical performance of the components manufactured was unmatched by existing more traditional conventional High Temperature and High Pressure treatments technologies applied to conventionally and traditional-MAM manufactured components.

Example 11. For the manufacturing technologies described in this document where additively manufactured molds filled with metallic materials in particulate form are used, several additive manufacturing technologies and materials were tested. Some of those tests are reported in this example along with the properties of some of the polymeric materials used.

The relevant properties of some polymeric materials used to manufacture different types or molds (some of them with complex geometries and internal features) through different technologies, including AM (FDM, FFF; SLA, DLP, DLS based on CLIP, CDLP, SLS, SHS, W., DOD; BJ, MJF: DED—; BAAM with a print head similar to FDM, FFF or DED) were tested as shown in the following Table:

| | | | HDT at | HDT at | | Tensile | Tensile | Elastic |
|---|---|---|---|---|---|---|---|---|
| | Tg | Tm | 0.455 MPa | 1.82 MPa | Vicat | strength | modulus | modulus |
| Polymer | (° C. | (° C.) | (° C.) | (° C.) | (° C.) | (MPa) | (MPa) | (GPa) |
| Resin 1 | 62 | | | | | 8 | 3500 | <3.5 |
| Resin 2 | 62 | | | | | | | <2.14 |
| PP | 0 | | 62 | | 107 | | | |
| PP*** | 0 | 139 ± 2 | | 56 ± 5 | | 29 ± 1 | 1400 ± 100 | 1.15 ± 0.025 |
| PP**** | 0 | 139 | 71 | 56 | | 25 | 1400 | 1.15 |
| PEBA | | 150 | | | | 8 | 80 | |
| PA121 | 50 | 187 | 175 | 95 | | 48 | 1700 | |
| PA122 | 50 | 176 | | | 163 | 52 | 1800 | 1.5 |
| PS | 105 | | | | | 5.5 | 1600 | |
| PCL* | −59 | 79 | 57 | | | 45 | 350 | |
| PCL** | −59 | 58-60 | | | | 17.5 | 470 | 0.41 |
| PLA 1 | 57 | 150 | | 65 | 85 | 110 | 3309 | |
| PLA 2 | 54-64 | 145-160 | | 56 | | 108 | 3600 | |
| HIPS | 100 | | | 79 | 100 | 38 | 1750 | |
| LDPE | −125 | 112 | | | 95 | 13.5 | 115 | |
| HDPE | −125 | 132 | | | 79 | 27 | 1100 | |
| PMMA | 90 | 155 | | | 77 | 51 | | 2.3 |
| ABS | 108 | 240 | 96 | 82 | | 31 | 2200 | 2.1 |
| PC | 150 | 225 | 148 | 133 | 145 | 76.4 | 2310 | 2.13 |

*The molecular weight was 75000.
**The molecular weight was 47500-130000
***Cristallinity >20%
**** Cristalinity >30%.

All melting temperatures (Tm) were measured following test conditions of IS011357-1,-3:2016. Moreover, the HDT at 1.82 MPa and glass transition temperature (Tg) were determined following test conditions of ASTM D648-07 and ASTM D3418-12 respectively. HDT at 0.455 MPa was determined following test conditions of ISO 75-1:2013. In all the cases measurements were run in triplicate to ensure the reproducibility of the assay and using a test specimen manufactured using molding method A.

Some examples of polymeric materials used to manufacture molds using different AM technologies, as shown in the Table below:

| AM technology | Polymers |
|---|---|
| SLA | Resin 1, Resin 2, Epoxy resin, UF, MF |
| DLP | Resin 1, Resin 2, PF, UF, MF |
| CDLP | Resin 1, Resin 2, Epoxy resin, UF, MF |
| SLS | PP, PP***, PP****, PEBA, PA122, PS, PCL2, PVC, |
| | Kollidon VA64, Kollidon 12FP, Epoxi resin, PA6, PE, |
| | PA11, PHA, PHB |
| MJF | PA121, PPO, PA6, PA122, PA11 |
| FDM | PP (homopolymer), PCL1, PLA1, PLA2, HIPS, LDPE, |
| | HDPE, PMMA, ABS, SAN, PPO, PVC, PVA, PC, |
| | POM, PE, PET, PBT, UP, PHA, PHB |
| BJ | PVA, PMMA, PA12, PA6 |
| DOD | Resin 1, Resin 2, Epoxy resin, PF |
| PIM | PET, PP, PA6, HDPE |

***Cristallinity >20%
****Cristalinity >30%.

Example 12. Several test components were manufactured wore manufactured using additive manufactured molds filled with metallic materials in particulate form. The molds were manufactured as described in this document, the cases described in examples 1, 11 and 13 to 15 were also tested (in some tests, the molds were manufactured using several technologies: FDM, FFF; SLA, DLP, DLP projecting holograms, DLS based on CLIP, CDLP, SLS, SHS, MJ, DOD; BJ, MJF; DED—; BAAM with a print head similar to any of those used in the technologies described above), while it was possible to achieve satisfactory results with all of these technologies, several provided good results and a few provided exceptional results. The organic materials mentioned in this document were used to manufacture the molds, amongst them the materials included in examples 1, 2, 3, 4, 9, 11, and 12 to 15, while it was possible to achieve satisfactory results with all of these organic materials, several provided good results and a few provided exceptional results. The metal comprising materials described in this document were used to fill the molds, amongst them those included in examples 1, 3, 4, 11 to 15 and 16 to 30, while it was possible to achieve satisfactory results with all of these metal comprising materials, several provided good results and a few provided exceptional results. The manufacture of the dies and other components was performed according to the manufacturing steps described in this document Certain particular advantages were found depending on the technology and materials used, but the performance was ensured regardless of the technology and materials employed. Some examples can be seen in FIG. 4 lower image, FIG. 5 and in the 3 middle segments of FIG. 6. Some of the molds were constructed by assembling together different pieces manufactured as described above and joined as can be seen in FIG. 7. Some were only assembled together, some were joined with a joining media (glue, cyanoacrylate, . . . ), some were joined by melting the organic material of the AM parts at the joining edges (with resistive heat, hot-tip, hot air blowing, etc.) in some cases also material was brought into the “melt” or directly another material was molten on top of the AM pieces edges to be joined (PP, PCL, and many other were tested). For exemplification purposes one amongst the hundredths of tests performed in this example will be further discussed:

Within the technologies based on polymer additive manufacturing, the materials described in this document were tested. In example 11 some the properties of some of those materials are reported as well as the ones that were used for every manufacturing method for all metallic materials tested. As metallic powders to fill the molds, the ones described in this document were tested, which also comprised those described in examples 1, 2, 3, 5, 17 and 19 to 30. The Mixing strategies and other strategies described in examples 16 and 18 were all tested. Very good success was attained when applying the strategies defined in this document about the homogeneous pressure application in the pressure and/or temperature treatment —which are well exemplified in example 8, (also a particular example can be found in example 1)—. Also the strategies described in this document for the usage of microwave heating in the Pressure and/or Temperature treatment and exemplified in example 9 were very successful—also a particular example is provided in example 2-, of example 9 proved. Often the powders or powder mixtures when filled in the molds were chosen to have a particular % O and % N contents (% O: in most of the cases between 250 ppm and 19000 ppm, in most tests 410 to 4900 ppm, in several tests between 210 and 900 ppm; % N: in most of the cases between 12 ppm and 9000 ppm, in most tests 55 to 490 ppm, in several tests between 110 and 900 ppm). Several filling techniques were tested, encompassing different types of mixing strategies for blending the powders and also vibration and other means of improving the filling of the molds.

In almost all cases, the filled molds were sealed (by gluing a lid, joining a lid by melting, encapsulating, bagging with or without vacuum, making a conformal mold around—by immersion in a liquid elastomer, or spraying, or painting with a elastomer/polymet comprising solution, etc). A Pressure and/or temperature treatment was then applied. A lot of attention was placed on that step. In most of the cases maximum pressures between 6 MPa and 2100 MPa were reached, in most tests maximum pressures between 110 MPa and 990 MPa were reached, in several cases between 220 MPa and 590 MPa. In most of the tests the Pressure and/or Temperature treatment also encompassed the raising of the temperature (in most tests maximum temperature between 46° C. and 995° C., in many tests between 106° C. and 495° C., and in several cases between 76° C. and 245° C.). In some tests, what was most interesting and thus monitored was the maximum temperature gradient of the pressurized fluid (in most cases between 6° C. and 380° C., in many cases between 11° C. and 245° C., in several cases below 6° C. and in several cases between 105° C. and 380° C.). One interesting variable was the optimum processing time which was often between 246 min and 119 hours, sometimes between 410 minutes and 23.9 hours, but when the strategies of example 9 were tested it could be cut to times between 1 minute and 54 minutes, in fact often the optimum time was then cut to less than 21 minutes and even less than 8 minutes—examples 14 and 15 exemplify this effect-.

In most cases the Pressure and/or temperature treatment comprised 3 steps as described in this document:
I) Subjecting the mold to high pressure
II) While keeping a high pressure level raising the temperature of the mold, and
III) While keeping a high enough temperature, releasing some of the to the mold applied pressure

For the right amount of maximum pressure in step i) (in almost all cases values between 10 MPa and 1900 MPa were used; in most tests between 20 MPa and 690 MPa, in many tests between 60 MPa and 490 MPa) in step ii) the temperature of the mold was raised (in most tests to a maximum temperature between 350 K and 690 K, in many tests between 380 K and 560 K), the right pressure level in step ii) (was in most cases between 5.5 MPa and 1300 MPa; in many tests between 105 MPa and 860 MPa, in several tests between 215 MPa and 790 MPa). A high enough temperature in step iii) (was in most tests between 380K and 690K, in many tests between 400 K and 660 K), releasing at least some of to the mold applied pressure as to attain a pressure in most cases below 390 MPa, in many tests below 19 MPa, in several tests below 0.2 MPa, in fact in many tests the pressure was completely released in this step.

From this stage on:
For some tests a debinding step was carried out, as described in this document.
For some tests the debinding step was omitted.
For some tests a second Pressure and/or temperature treatment was applied, following the indications of this document which comprise also the ones provided in this example.
For some tests the second Pressure and/or step was omitted.
For some tests a % O and/or % N fixing step was applied.
For some tests the fixing step was omitted
For some tests a consolidation step was applied as described in this document—several strategies were tried amongst others all the strategies exemplified in example 13 and 3 to 7.
For some tests the consolidation step was omitted and a densification step was applied instead.
   the strategies of example 10 were also tested—
For some tests the consolidation and densification steps were applied simultaneously.—the strategies of example 10 were also tested—
For some tests a densification step was applied—the strategies of example 10 were also tested—
For some tests the densification step was omitted
For some tests a Heat treatment step was applied
For some tests the Heat treatment step was omitted
For some tests machining was performed on the component (after the debinding step, after the fixing step, after the densification step and/or after the Heat treatment step).
For some tests machining was omitted.

Example 13. Several configurations for the consolidation step were tested. In most of the test the maximum pressure was kept between at least 1 mbar, and less than 4900 bar, in many test, the maximum pressure was kept between 10 mbar and 790 bar, and even in some other test the maximum pressure was kept below 89 bar. Mean pressures were maintained in all cases between such limits. The maximum temperatures used were in some cases above 0.36*Tm and below 0.96*Tm, in most of the cases between 0.46*Tm and 0.88*Tm and even maximum temperatures between 0.54*Tm, 0.66*Tm to 0.78*Tm and 0.68*Tm were tested. For certain configurations, temperatures above Tm where also tested, in many cases up to 1.9*Tm, and even from 0.96*Tm to 1.49*Tm. For some of these tests the volume phase of liquid was determined normally between 0.2 vol % and 39 vol %, in many cases below 29 vol % an even below 19 vol %.

In some other test, the temperature was raised while keeping maximum pressures below 900 bar, below 90 bar and in some test below 1.9 bar. The maximum temperatures reached in this first step were between 0.89*Tm and 0.36*Tm, in many test, between 0.46*Tm, and 0.79*Tm and even in some test below 0.69*Tm. These conditions were maintained in some test for less than 590 min, less than 390 min and even in some test less than 240 min. After that, pressures where raised, in many cases the maximum pressures used were between 210 bar and 6400 bar, in some test between 551 bar and 2900 bar, in some test even maximum pressures below 1900 MPa were also tested. Then, the temperatures were raised to 0.76*Tm, in some test to 0.86 Tm and in some test to 0.96*Tm maintaining such conditions for 16 min, in other test 66 minutes, and in other test at least 178 min.

Example 14. A large mold which was the negative of the component depicted in FIG. 8—where the base was left open and a corresponding lid was printed with the same material—was manufactured, by means of PP powder SLS printing with a mean wall thickness of 2 mm—the wall was quite constant with deviations of less than 1 mm—The mold was cleaned and removed of loose powder and the 4^{th} mixing strategy specified for Alloy 4 in example 17 was mixed during 30 minutes in a powder blender and filled into the mold with aid of vibration and agitation achieving an apparent density of 76.8%. The mold was sealed with the printed lid by means of melting the edges of the lid and the mold together. The sealed mold was then subjected to a Pressure and/or temperature treatment—pressure transmitting container and appropriate fluid according to example 8 were employed—At this point a pressure of 150 MPa was applied at room temperature for step i), then the temperature was slowly raised to 150° C. and maintained for 2 h which had the collateral implication of a pressure raise up to 220 MPa for step ii), then the temperature was slowly allowed to drop while the chamber pressure was released, the whole processing time was 7.5 hours.

Example 15. A large mold which was the negative of the component depicted in FIG. 8—where the base was left open and a corresponding lid was printed with the same material—was manufactured, by means of PP powder SLS printing with a mean wall thickness of 2 mm—the wall was quite constant with deviations of less than 1 mm—The mold was cleaned and removed of loose powder and the 4^{th} mixing strategy specified for Alloy 4 in example 17 was mixed during 30 minutes in a powder blender and filled into the mold with aid of vibration and agitation achieving an apparent density of 76.8%. The mold was sealed with the printed lid by means of melting the edges of the lid and the mold together. The sealed mold was then subjected to a Pressure and/or temperature treatment—pressure transmitting container and appropriate fluid according to example 8 were employed—At this point a pressure of 350 MPa was applied at room temperature for step i), then the temperature was very rapidly raised to more than 120° C. on the powder by means of microwave heating as described in example 9-2.45 GHz: 6000 W in pulses of 2 minutes—and maintained for 5 minutes which had the collateral implication of a pressure raise up to 370 MPa for step ii), then the temperature was slowly allowed to drop while the chamber pressure was released, the whole processing time was 18 minutes.

Example 16. Thousands of iron-based powders and powder mixtures were tested. The different strategies in terms of iron-based powder and powder mixtures described in this document were tested. A lot of attention was placed on the iron-based powder nature. In the cases that a sole powder was used, different natures were tested. In the case of iron-based powder mixtures, mixtures of powders with different nature were tested. The reporting of the results has been split in several examples (mainly 16 to 23). Because several thousand results can not be reported, it has been decided to report at least some of those compositions where in all executions at least one relevant characteristic was better in comparison to the exactly same composition melt in the LAB with a laboratory arc melting furnace—Edmund Bühler GmbH Arc Melter AM200—examples 17 and 19 to 23 report the composition when tested as a single powder or overall composition of the mixture when tested as a mix of different powders. The tests that were always performed in each one of those overall compositions as single powder and as powder mixtures are reported in example 18, while in this example, some of the tests that were only performed or at least more often performed to iron-based powders are reported in this example. The tests that were not performed to all the compositions reported are not reported.

As already mentioned in example 18, every composition was tested as a single powder, and amongst them water atomized, oxide reduced and crushed powders. Those are normally not used in conventional MAM of iron-based alloys and were given special attention in this example.

Every composition was tested as many different mixtures of powders of different natures but providing the same “overall” composition as mentioned in example 18, and some different natures mentioned in example 18 were even more in depth tested in this example.

One such case was the case of the carbonyl powders usage. For the iron-based alloy powder mixtures many more tests than usual were made with mixtures comprising carbonyl iron powder. Many tests were done with carbonyl iron as at least part of the small powder. Special attention was placed to mixtures with LP as irregular powders (in most cases sphericity between 22% an 89%, in many cases between 36% and 79%) (with contents in most of the cases between 42% and 79%, in many cases between 46% and 66%) and high carbonyl percentages (in most of the cases between 11% and 59%, in many cases between 21% and 39%) often with at least one interstitial at a lower level than the final overall composition in the LP power (in several cases % C les than half what it was at the end, often less than 10× smaller content, sometimes regulated trough content being in most of the cases below 0.15%, and in many cases below 0.1%), often with additional SP powders besides the carbonyl iron (many alternatives were tried here, worth mentioning one in which at least one additional SP was incorporated and where different relevant elements had significant differences in content amongst the different SP powders and the LP powder. The same strategy was also tested with LP spherical powder (in most cases sphericities above 76%, in many cases above 92%) in which case the amounts of LP and carbonyl iron varied, but not necessarily the strategies followed with the other SP powders—LP contents: in most of the cases between 51% and 89%, in many cases between 65% and 78%; carbonyl iron—in most of the cases between 6% and 45%, in many cases between 17% and 26%). Some compositional strategies worth mentioning when looking at all elements besides the interstitials for those strategies where at least some interstitials were kept at a lower level: LP with roughly the same composition as the final composition (as mentioned, interstitials aside) and all the SP except the carbonyl-iron with the compositions arranged to deliver an overall composition of all the SP powders together with the carbonyl-iron similar to that of the LP powder (in several cases the SP were atomized powders with tailored composition, but also in some cases at least some of the SP powders were ferro-alloys or generic master alloys). Also the powder mixture consisting on SP as a majoritarian powder carbonyl iron and an LP which was a master-alloy to deliver the desired overall composition were tried both with irregular and with spherical LP.

Obviously all mixtures with a significant difference in at least one relevant element were tested as is mentioned in example 18, but special attention was given to the elements that have a strong strengthening when present in solid solution, in this respect tests were carried out in which the alloying of the LP was limited so that the solid solution strengthening would not surpass the equivalent strengthening by solid solution of 5% Cr in a steel with the same % C, % N and % O level, that lead to significant differences in at least one element for the large powder compared to at least one of the small powders. Also attention was given in some tests to the majoritarian SP powder, where the alloying was limited so that the solid solution strengthening would not surpass the equivalent strengthening by solid solution of 5% Cr in pure iron.

Example 17. Several High Thermal Conductivity steels with particular attention to Tool Steels were tested. The different strategies in terms of powder and powder mixtures described in this document were tested, amongst others all the strategies described in examples 16 and 18 were tested for every single overall composition in the table below. In particular many tests were performed incorporating iron carbonyl powders. In several tests incorporating mixes of powders of different size, carbonyl powder was used as one of the smaller powders. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of examples 16 and 18 at least one relevant characteristic was better in comparison to the exactly same composition melt in the LAB with a laboratory arc melting furnace—Edmund Bühler GmbH Arc Melter AM200—Also in most of the cases when following the strategies of example 16 (which incorporates all the strategies of example 18) and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| # | % Cr | % Mn | % Si | % Mo | % Co | % W | % Ni | % V | % C | % O | AA | OTHERS |
|---|---|---|---|---|---|---|---|---|---|---|---|---|
| 1 | 0.01 | 0.59 | 0.1 | 1.6 | — | — | — | — | 0.19 | | | |
| 2 | | — | — | 2.7 | | 0.9 | 1.4 | 0.6 | 0.41 | 0.2 | 0.06 | |
| 3 | 1 | 0.01 | — | 1.5 | — | — | | — | 0.16 | 0.08 | 0.3 | |
| 4 | 0.01 | 0.82 | 0.03 | 3.27 | — | — | — | 0.44 | 0.39 | — | | |
| 5 | — | 0.02 | 0.03 | 1.8 | — | — | | 0.1 | 0.22 | | | |
| 6 | — | 0.68 | — | 3.18 | — | — | — | 0.41 | 0.2 | 1.3 | 5.1 | 0.9% N |
| 7 | 0.019 | 0.022 | 0.04 | 3.36 | | 0.1 | | 0.002 | 0.29 | | | |
| 8 | 0.02 | 0.025 | 0.04 | 3.59 | | 0.6 | | 0.003 | 0.28 | | | |
| 9 | 0.01 | 0.02 | 0.04 | 3.7 | | 1.19 | | <0.005 | 0.28 | 0.864 | 3.2 | |
| 10 | 0.01 | 0.02 | 0.05 | 3.71 | | 1.2 | 0.84, | 0.6 | 0.39 | | | |
| 11 | 0.01 | 0.02 | 0.04 | 3.63 | 3 | 1.63 | | 0.81 | 0.41 | | | Hf, Nb, Zr |
| 12 | 8.2 | 0.14 | 0.11 | 1.15 | 6 | 0.02 | | 0.87 | 0.4 | | | |
| 13 | 0.01 | 0.02 | 0.05 | 3.4 | | 1.08 | | <0.005 | 0.27 | 0.0459 | 1.7 | Al |
| 14 | 0.01 | 0.019 | 0.05 | 3.7 | | 1.01 | | 0.005 | 0.29 | | | |
| 15 | 0.01 | 0.24 | 0.05 | 3.39 | | 1.11 | | 0.43 | 0.33 | | | Hf |
| 16 | 0.01 | 0.12 | 0.05 | 3.36 | | 1.15 | — | 0.44 | 0.32 | | | |
| 17 | 0.01 | 0.02 | 0.05 | 3.62 | | 1.18 | | 0.004 | 0.29 | 0.135 | 0.5 | Nb |
| 18 | 0.01 | 0.14 | 0.05 | 3.58 | | 1.27 | 2.04 | <0.005 | 0.33 | | | |
| 19 | 0.01 | 0.14 | 0.07 | 3.58 | | 1.16 | — | 0.65 | 0.41 | | | |
| 20 | 0.01 | 0.26 | 0.05 | 3.64 | | 1.1 | 3.09 | 0.46 | 0.33 | | | |
| 21 | 0.01 | 0.26 | 0.05 | 3.7 | | 1.36 | | 0.43 | 0.33 | 0.766 | 2.84 | Nb |
| 22 | 0.01 | 0.21 | 0.04 | 3.2 | | 1.04 | | 0.3 | 0.21 | | | Nb |
| 23 | 0.01 | 0.02 | 0.02 | 3.7 | | 2.3 | | <0.005 | 0.31 | | | Nb, Zr |
| 24 | 0.01 | 0.11 | 0.02 | 3.9 | | 2 | — | <0.005 | 0.37 | | | |
| 25 | 0.01 | 0.02 | 0.05 | 3.64 | | 1.97 | 1.86 | 0.7 | 0.44 | 1.28 | 4.73 | |
| 26 | 0.01 | 0.02 | 0.05 | 3.73 | | 1.8 | 2.05 | 0.69 | 0.43 | | | |
| 27 | 0.01 | 0.09 | 0.04 | 3.1 | | 1.68 | Co | <0.005 | 0.32 | | | |
| | | | | | | | 3.00 | | | | | |
| 28 | 0.01 | 0.015 | 0.03 | 3.6 | 3 | 1.09 | | <0.005 | 0.29 | | | |
| 29 | <0.01 | <0.01 | <0.01 | 3.57 | | 1.35 | 2.96 | 0.44 | 0.39 | 1.45 | 5.39 | |
| 30 | 0.1 | 0.17 | 0.1 | 3.1 | | 1.7 | | 0.03 | 0.32 | | | Hf, B, Zr |
| 31 | <0.01 | 0.058 | <0.05 | 3.9 | | 1.4 | | 0.484 | 0.356 | | | Hf, Zr, Nb |
| 32 | <0.01 | 0.061 | <0.05 | 3.81 | | 1.41 | 0.017 | 0.461 | 0.353 | | | |
| 33 | 0.0108 | 0.055 | <0.05 | 3.68 | | 1.49 | 0.47 | 0.44 | 0.326 | 0.58 | 2.17 | |
| 34 | <0.01 | 0.055 | <0.05 | 3.89 | | 1.67 | 0.481 | 0.452 | 0.464 | | | |
| 35 | <0.01 | 0.051 | <0.05 | 3.77 | | 1.31 | 0.488 | 0.452 | 0.299 | | | |
| 36 | <0.01 | 0.061 | <0.05 | 3.8 | | 2.46 | 0.516 | 0.457 | 0.404 | | | |
| 37 | <0.01 | 0.059 | <0.05 | 3.81 | | 1.35 | 0.95 | 0.473 | 0.377 | 0.99 | 3.69 | |
| 38 | 0.012 | 0.054 | <0.05 | 3.89 | | 1.64 | 0.969 | 0.47 | 0.345 | | | |
| 39 | <0.01 | 0.055 | <0.05 | 3.77 | | 1.58 | 1.01 | 0.462 | 0.336 | | | |
| 40 | <0.01 | 0.06 | <0.05 | 3.75 | | 1.36 | 1.41 | 0.451 | 0.409 | | | |
| 41 | <0.01 | 0.06 | <0.05 | 3.73 | | 1.51 | 1.58 | 0.457 | 0.371 | 0.58 | 2.14 | |
| 42 | <0.01 | 0.062 | <0.05 | 3.66 | | 2 | 1.62 | 0.448 | 0.467 | | | |
| 43 | <0.02 | 1.12 | <0.05 | 3.7E−4 | | 2.2 | 2 | <0.001 | 0.36 | | | |
| 44 | <0.01 | 0.062 | <0.05 | 3.67 | | 1.69 | 2.12 | 0.45 | 0.401 | | | |
| 45 | <0.01 | 0.06 | <0.05 | 3.66 | | 1.46 | 2.15 | 0.463 | 0.367 | 0.52 | 1.95 | |
| 46 | 0.066 | 0.145 | <0.05 | 3.03 | | 1.93 | 2.56 | 0.016 | 0.403 | | | |
| 47 | 0.061 | 0.149 | 0.103 | 3.04 | | 1.93 | 2.58 | 0.012 | 0.336 | | | |
| 48 | 0.091 | 0.160 | 0.085 | 2.92 | | 1.97 | 2.84 | 0.017 | 0.24 | | | |
| 49 | 0.0327 | 0.117 | 0.119 | 3.35 | | 1.92 | 2.87 | <0.001 | 0.383 | 1.04 | 3.87 | |
| 50 | 0.094 | 0.15 | 0.08 | 3.02 | | 2.07 | 2.98 | 0.018 | 0.35 | | | |
| 51 | 0.12 | 0.21 | 0 | 2.81 | | 2.1 | 2.98 | 0.08 | 0.32 | | | |
| 52 | 0.071 | 0.144 | <0.05 | 3.01 | | 1.93 | 2.99 | 0.017 | 0.322 | | | |
| 53 | 0.07 | 0.17 | 0.13 | 3.13 | | 1.9 | | 0.03 | 0.32 | 1.42 | 5.26 | Cu, |
| | | | | | | | | | | | | 3.00 |
| 54 | 0.12 | 0.135 | <0.05 | 3.1 | | 1.99 | 3.01 | 0.016 | 0.34 | | | |
| 55 | <0.01 | 0.066 | <0.05 | 3.66 | | 1.39 | 3.04 | 0.465 | 0.371 | | | |
| 56 | 0.085 | 0.166 | <0.05 | 3.06 | | 2.1 | 3.07 | 0.02 | 0.402 | | | |
| 57 | 0.074 | 0.158 | 0.088 | 3.08 | | 2.13 | 3.07 | 0.016 | 0.384 | 0.69 | 2.58 | |
| 58 | 0.1 | 0.16 | 0.14 | 2.92 | | 1.75 | 3.08 | 0.03 | 0.32 | | | |
| 59 | 0.079 | 0.168 | 0.104 | 3.09 | | 2.08 | 3.08 | 0.019 | 0.384 | | | |
| 60 | <0.01 | 0.070 | <0.05 | 3.67 | | 1.5 | 3.1 | 0.459 | 0.392 | | | |
| 61 | 0.07 | 0.24 | 0.01 | 3.2 | | 2.39 | 3.11 | 0.05 | 0.24 | 0.34 | 1.26 | |
| 62 | 0.0832 | 0.213 | 0.0958 | 3.63 | | 2.52 | 3.19 | 0.0216 | 0.392 | | | |
| 63 | <0.01 | 1.98 | 1.59 | 0.25 | | <0.01 | 3.21 | o | 0.8 | | | |
| 64 | <0.01 | 1.98 | 1.59 | 0.25 | | <0.01 | 3.73 | 3.0 | 1.4 | | | |
| 65 | <0.01 | 1.98 | 1.59 | 0.25 | | <0.01 | — | 2.4 | 0.8 | 0.97 | 3.58 | |
| 66 | <0.01 | 1.56 | 1.5 | 0.05 | | <0.01 | — | 0.04 | 0.388 | | | |
| 67 | 0.04 | 1.61 | 1.62 | 0.1 | | <0.01 | — | 0.03 | 0.391 | | | |
| 68 | 2.08 | 1.53 | 1.43 | 0.09 | | <0.01 | 0.06 | 0.05 | 0.388 | | | |
| 69 | 0.01 | 1.61 | 1.52 | 0.05 | | <0.01 | 1.15 | 0.02 | 0.388 | 1.4 | 5.21 | |
| 70 | 0.05 | 0.2 | 0.05 | 4.4 | | 3.4 | 3.1 | | 0.345 | | | |
| 71 | 0.07 | 0.21 | 0.11 | 4.6 | | 3.5 | 3.4 | | 0.357 | 0.837 | 3.19 | |
| 72 | | | | 3.63 | | 1.44 | <0.005 | <0.005 | 0.293 | | | Hf, Zr, B |
| 73 | | | | 3.63 | | 1.44 | <0.005 | <0.005 | 0.59 | | | Hf, Zr, B |
| 74 | | | | 3.229 | | 0.977 | <0.005 | <0.005 | 0.511 | | | Hf, Zr, B |
| 75 | | | | 3.24 | | 0.981 | <0.005 | <0.005 | 0.235 | | | Hf, Zr, B |
| 76 | | | | 3.3 | | 1 | o | o | 0.284 | | | Hf, Zr, B |
| 77 | | | | 3.3 | | 1 | o | o | 0.579 | | | Hf, Zr, B |
| 78 | | | | 3.3 | | 1 | o | o | 0.253 | | | Hf, Zr, B |
| 79 | | | | 3.3 | | 1 | o | o | 0.558 | | | Hf, Zr, B |
| 80 | | | | 3.3 | | o | o | o | 0.53 | | | Hf, Zr, B |

AA - referes to the sum of % Y + % Sc + % REE

Illustrative example of different natures tested for each single alloy overall composition following the strategies of examples 16 and 18:

Alloy 4 as a single gas atomized powder (D10=15 micron; D50=43 micron; D90=55 micron).

Alloy 4 as a single centrifugal atomized powder but with lower % C (D10=21 micron; D50=72 micron; D90=95 micron)—% C is added in every particular processing in a different way, from admixed graphite, employment of carburization atmospheres, pickup from mold pyrolysis or other organic sources, etc.

Alloy 4 as a mixture of 2 gas atomized powders —both with the composition of alloy 4 but without the % C—72.6% with a size D50=80 microns and 27% with a size of D50=11 microns. % C is added in every particular processing in a different way, from admixed graphite, employment of carburization atmospheres, pickup from mold pyrolysis or other organic sources, etc.

Alloy 4 as a mixture: 73% of centrifugal atomized powder with the composition similar to alloy 4 without the % C (D10=90 micron), 24% of LC carbonyl iron (D50=6 micron), roughly 2.5% of fine gas atomized powder with the composition required to match an overall composition of alloy 4 without the % C (D90=12 micron) and roughly 0.5% C on the form of graphite powder (D50=20 microns)—The amount of graphite depending on the shaping method to be used as well as the processing methods of the present invention since there are many different ways to fix the % C—

Alloy 4 as a mixture: 60% of water atomized powder with the composition of Alloy 4 but without % C (D50=110 microns), 35% of LC carbonyl iron (D50=4 micron), roughly 4.5% of a gas atomized powder with the required composition to match an overall composition of alloy 4 (D50=32 microns), and roughly 0.5% C on the form of graphite powder (D50=30 microns)—The amount of graphite depending on the shaping method to be used as well as the processing methods of the present invention since there are many different ways to fix the % C-Alloy 4 as a mixture: 55% of water atomized powder with the composition of Alloy 4 but without % C and % Mn and D50=160 microns, roughly 0.5% C on the form of graphite powder (D50=30 microns)—The amount of graphite depending on the shaping method to be used as well as the processing methods of the present invention since there are many different ways to fix the % C— and roughly 44.5% of a centrifugal atomized powder with the required composition to match an overall composition of alloy 4 (D50=26 microns).

Alloy 4 as a mixture: 60% of water atomized iron powder with 1.6% Mo and D50=40 microns, 30% of carbonyl iron (D90=11 microns). 3.3% of 70Mo30Fe crushed ferro-alloy powder (D90=12 microns), roughly 0.5% C on the form of graphite powder (D50=4 microns)—The amount of graphite depending on the shaping method to be used as well as the processing methods of the present invention since there are many different ways to fix the % C— and roughly 6.3% of a gas atomized powder with the required composition to match an overall composition of alloy 4 (D50=9 microns).

Alloy 4 as a mixture: 58% of oxide reduction iron powder (D50=135 microns), 27.8% of carbonyl iron (D10=2 microns), 4.7% of 70Mo30Fe crushed ferro-alloy powder (D50=27 microns), roughly 0.5% C on the form of graphite powder (D50=4 microns)—The amount of graphite depending on the shaping method to be used as well as the processing methods of the present invention since there are many different ways to fix the % C— and roughly 9% of a centrifugal atomized powder with the required composition to match an overall composition of alloy 4 (090=35 microns).

Etc.

Example 18. Thousands of powders and powder mixtures were tested. The different strategies in terms of powder and powder mixtures described in this document were tested. A lot of attention was placed on the powder nature. In the cases that a sole powder was used, different natures were tested. In the case of powder mixtures, mixtures of powders with different nature were tested. The reporting of the results has been split in several examples (mainly 16 to 30). Because several thousand results can not be reported, it has been decided to report at least some of those compositions where in all executions at least one relevant characteristic was better in comparison to the exactly same composition melt in the LAB with a laboratory arc melting furnace—Edmund Buhler GmbH Arc Melter AM200—examples 16, 17 and 19 to 30 report the composition when tested as a single powder or overall composition of the mixture when tested as a mix of different powders. The tests that were always performed in each one of those overall compositions as single powder and as powder mixtures are reported in this example, some of the tests that were not performed to all the compositions reported are not reported. For clarification purposes in most examples where the compositions are reported two or at most three implementations according to the present example are reported—for better comprehension only— of the tests performed.

Every composition was tested as a single powder. In this case the different natures tested refer amongst others to size, morphology, how the powder was obtained, hardness, etc. Almost all of the cases used powders with a size between 0.6 nm and 1990 microns, for most tests between 2 and 290 microns, for many cases between 22 and 190 microns and in some cases between 22 and 90 microns. In some tests spherical powders were employed (in almost all cases sphericity above 76%, in most tests above 82%, in many tests above 92% and in some tests 100%) and in some others irregular powders were used (sphericity in almost all cases between 22% and 89%, in most tests between 36% and 79%, in many cases between 51% and 74%, in some cases below 69%). Powders were produced by different routes (water atomization, centrifugal atomization, gas atomization, mechanical crushing, reduction, carbonyl decomposition, etc.).

Also special attention was placed at testing compositions incorporating % Y+% Sc+% REE or % Y+% Sc+% REE+% Al or % Y+% Sc+% REE+% Ti and also at the influence of these elements in comparison to the % O present, often % O levels were fixed during the processing. When looking at atomic percent the level of % O was in most of the cases between 0.2 and 5 times the sum of atomic percents of some of *% Y, % Sc, % REE, % Al, % Ti.

In some tests attention was placed at the hardness of the powders and the necessary treatments were employed to lower the hardness to the desired level. Hardness levels below 289 HV were often attained, in some cases hardness levels below 148 HV, below 89, below 49 and even below 28 HV were attained.

Some powders tested were treated in order to fix the original interstitial level, in some cases this treatments were performed in an oven with a reducing atmosphere and microwave heating. In such cases often the powders were kept in motion during the treatment, while it was possible to achieve satisfactory results with all of these different natures of a same powder composition, several provided good results and a few provided exceptional results.

For certain natures of the same powder composition, a narrow range showed an improved performance, sometimes coinciding with other particular choosing of variables, as a couple examples from the thousands implemented: A gas atomized spherical powder with a sphericity larger than 82%, a particle size with a D50 between 2 microns and 90 microns and a hardness below 289 HV, or a centrifugal atomized spherical powder with a sphericity above 92%, with a D10 between 6 and 19 microns and a D90 between 51% and 90%, or an irregular water atomized powder with a sphericity smaller than 74% and a D50 between 22 and 90 and a % Y+% Sc+% REE between 0.052% and 6%, presented good performance results but also varying depending on the values of other variables.

Certain particular advantages were found depending on the particular natures of the powder mixtures used, but the performance was ensured regardless of the powder mixture concept employed. The high performance achieved with several of these mixing concepts in terms of at least one relevant property was not matched by the properties of a cast alloy of the same overall composition.

Every composition was tested as many different mixtures of powders of different natures but providing the same “overall” composition. In this case the different natures tested refer amongst others to composition, size, morphology, how the powder was obtained, hardness, etc.

Example 19. Several Ultra High Strength Stainless Steels were tested. The different strategies in terms of powder and powder mixtures described in this document were tested, amongst others all the strategies described in examples 16 and 18 were tested for every single overall composition in the table below. In particular many tests were performed incorporating iron carbonyl powders. In several tests incorporating mixes of powders of different size, carbonyl powder was used as one of the smaller powders. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of examples 16 and 18 at least one relevant characteristic was better in comparison to the exactly same composition melt in the LAB with a laboratory arc melting furnace—Edmund Buhler GmbH—Arc Melter AM200—Also in most of the cases when following the strategies of example 16 (which incorporates all the strategies of example 18) and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| # | % C | % Cr | % Ni | % M | % Nb | % N | % Mo | % Al | % Ti | % O | AA | OTHERS |
|---|---|---|---|---|---|---|---|---|---|---|---|---|
| 1 | | 19 | 14 | | | | | | | | | |
| 2 | | 19 | 8 | | | | | | 0.3 | 0.1 | 0.2 | |
| 3 | | 19 | 11 | | | | | | | 0.1 | 0.3 | |
| 4 | | 19 | 14 | | | | | 0.6 | 1.1 | 0.9 | 1.6 | |
| 5 | | 19 | 17 | | | | | | | 1.4 | 5.8 | |
| 6 | | 19 | 9 | | | 0.9 | | | | | | |
| 7 | | 19 | 4 | | | 0.9 | | 1.1 | | 0.4 | 0.1 | |
| 8 | | 19 | 6 | | | 0.9 | | | | 0.1 | 0.3 | |
| 9 | | 19 | 8 | | | 0.9 | | | 0.8 | 0.8 | 1.7 | |
| 10 | | 19 | 11 | | | 0.9 | | | | 1.5 | 5.6 | |
| 11 | | 18 | | 15 | | 0.9 | | | | 0.05 | 0.2 | |
| 12 | | 19 | 11 | | | 0.9 | | | | | | |
| 13 | | 18 | | 18 | | 0.45 | | | | 0.05 | 0.1 | |
| 14 | | 20 | 8 | 5 | 2 | 0.9 | | | | 0.6 | 2.3 | |
| 15 | | 18 | | 17.5 | | 0.9 | | | 2.1 | 0.6 | | |
| 16 | | 18 | | 15 | | 0.9 | | | | 0.05 | 3.5 | |
| 17 | | 19 | 8 | | | 0.9 | | | | 0.05 | 0.3 | |
| 18 | | 19 | 8 | 5 | | | | | | | | |
| 19 | | 23 | 8 | | | 0.9 | | | | 0.08 | 0.3 | |
| 20 | | 20 | 8 | 5 | 2 | 0.9 | | | | 0.1 | 0.3 | |
| 21 | | 25 | 5 | | | 0.45 | | | | 0.4 | 1.6 | |
| 22 | 0.8 | | | 30 | | | | | | 0.05 | 0.2 | |
| 23 | 0.8 | 5 | | 30 | | 0.1 | | | | | | |
| 24 | 0.8 | | | 30 | | | | | | 0.6 | 2.2 | |
| 25 | | 20 | 8 | 5 | 2 | 0.9 | | | | | | |
| 26 | | 20 | 8 | 5 | 2 | 0.45 | | | | 0.1 | 0.3 | |
| 27 | | 20 | 8 | 5 | 2 | 0.7 | | | | 0.4 | 1.6 | |
| 28 | | 20 | 8 | 5 | 2 | 0.9 | | | | 1.5 | 5.8 | |
| 29 | — | 11.6 | 11.2 | 0.1 | — | — | 1.1 | | 1.6 | 0.1 | 0.3 | |
| 30 | — | 11.4 | 11.2 | 0.1 | 0.25 | — | 1.0 | | 1.2 | | | |
| 31 | — | 11.5 | 11.1 | 0.15 | — | — | 1.0 | 1.1 | 0.9 | 0.15 | 0.5 | |
| 32 | — | 11.4 | 10.9 | — | — | 0.01 | 0.8 | | 1.1 | 0.6 | 2.2 | |
| 33 | % C | % Cr | % Ni | % M | % Nb | % N | % Mo | % Al | % Ti | % O | AA | |
| 34 | — | 11.4 | 11.5 | 0.1 | — | 0.8 | 0.9 | — | 2.1 | 0.1 | 0.3 | |
| 35 | — | 10.8 | 10.8 | — | — | — | 0.8 | — | 1.7 | | | |
| 36 | 0.01 | 12.1 | 9.9 | 0.1 | — | 0.1 | 1.1 | 0.6 | 1.1 | 0.1 | 0.3 | |
| 37 | — | 12.0 | 10.2 | — | 0.25 | | 0.9 | 0.8 | 1.2 | | | |
| 38 | 0.01 | 12.3 | 10.0 | 0.1 | | — | 1.1 | 1.1 | 1.0 | | | |
| 39 | — | 12.5 | 10.1 | | | 0.9 | 1.0 | 0.5 | 1.1 | 1.13 | 4.2 | |
| 40 | — | 12.2 | 10.2 | — | | | 1.0 | 0.4 | 2.3 | 0.03 | 0.1 | |
| 41 | — | 12.0 | 8.9 | 4.6 | — | 1.1 | 1.1 | — | 0.4 | 1.7 | 6.2 | |
| 42 | — | 15.1 | 11.1 | — | — | 0.6 | — | 0.4 | — | 0.9 | 3.5 | |
| 43 | — | 16.2 | 8.1 | 5.2 | — | 0.9 | 0.9 | — | 0.3 | 1.4 | 5.2 | |

AA—referes to the sum of % Y + % Sc + % REE

Illustrative example of different natures tested for each single alloy overall composition following the strategies of examples 16 and 18:

Alloy 36 as a single gas atomized powder with a +10/−55 micron distribution (D50=43 micron).

Alloy 36 as a mixture of 2 spherical powders —both with the composition of alloy 36-73% with a size D50=80 microns (centrifugally atomized) and 27% with a size of D50=10 microns (gas atomized).

Alloy 36 as a mixture: 73% of centrifugal atomized powder with the composition similar to alloy 36 without the % N (D10=73 micron), 15.53% of LC carbonyl iron (D50=4 micron), roughly 11% of fine gas atomized powder with the composition required to match an overall composition of alloy 36 without the % N (D90=˜9 micron) and 0.47% crushed CrN (D50=20 microns).

Etc.

Example 20. Several Cold Work Tool Steels were tested. The different strategies in terms of powder and powder mixtures described in this document were tested, amongst others all the strategies described in examples 16 and 18 were tested for every single overall composition in the table below. In particular many tests were performed incorporating iron carbonyl powders. In several tests incorporating mixes of powders of different size, carbonyl powder was used as one of the smaller powders. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of examples 16 and 18 at least one relevant characteristic was better in comparison to the exactly same composition melt in the LAB with a laboratory arc melting furnace—Edmund Bühler GmbH Arc Melter AM200—Also in most of the cases when following the strategies of example 16 (which incorporates all the strategies of example 18) and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| # | % Cr | % Mn | % Si | % Mo | % Co | % W | % Nb | % V | % C | % O* | AA | OTHERS | |
|---|---|---|---|---|---|---|---|---|---|---|---|---|---|
| 1 | 22.8 | 1.3 | 0.6 | 3.2 | — | — | — | — | 0.02 | 0.62 | 2.3 | | |
| 2 | 25.2 | 0.55 | 0.25 | 3.7 | — | 0.65 | — | — | 0.02 | | | 0.6% | Cu |
| 3 | 25.8 | 0.55 | 0.25 | 3.4 | — | 0.55 | — | — | 0.02 | | | 7% | Ni |
| 4 | 7.8 | 0.2 | 1.1 | 1.6 | — | 1.0 | — | 2.5 | 1.2 | 1.2 | 4.5 | | |
| 5 | 26 | 0.02 | 0.01 | 6.0 | — | — | — | — | 0.01 | | | 1.0% | Cu |
| 6 | 28 | 2 | 0.3 | 7.0 | — | — | — | — | 0.02 | | | 1.4% | Cu |
| 7 | 19.0 | 2.0 | 0.7 | 4.0 | — | — | — | — | 0.02 | | | 24.0% | Ni |
| 8 | 21.0 | 2.0 | 0.7 | 5.0 | — | — | — | — | 0.02 | | | 26% | Ni |
| 9 | 20.3 | 0.65 | 0.18 | 6.3 | — | — | — | — | — | | | 17.8% | Ni |
| 10 | 0.95 | 0.3 | 0.22 | 0.2 | — | — | — | 0.15 | 0.19 | | | 1.25% | Ni |
| 11 | 20.8 | 0.75 | 0.35 | — | — | — | — | — | 0.07 | | | 0.3% | Ti |
| 12 | 11.5 | 0.35 | 0.25 | — | — | — | — | — | 2.0 | 0.2 | 0.8 | | |
| 13 | 11.5 | 0.3 | 0.35 | 0.6 | — | 0.5 | — | 0.3 | 1.6 | | | | |
| 14 | 11.5 | 0.4 | 0.25 | — | — | 0.7 | — | — | 2.1 | | | | |
| 15 | 11.3 | 0.3 | 0.3 | 0.75 | — | — | — | — | 1.55 | | | | |
| 16 | 12.5 | 0.3 | 0.6 | 1.1 | — | — | — | 4.0 | 2.3 | 0.31 | 1.3 | | |
| 17 | 0.6 | 1.1 | 1.1 | — | — | — | — | — | 0.63 | | | | |
| 18 | 5.2 | 0.5 | 0.9 | 1.3 | — | — | — | 9.5 | 2.45 | | | | |
| 19 | 8.2 | 0.4 | 0.7 | 2.1 | — | — | — | 0.5 | 1.1 | | | | |
| 20 | 4.2 | 0.4 | 0.55 | 3.8 | 2.0 | 1.0 | — | 9.0 | 2.47 | 0.82 | 3.2 | | |
| 21 | 0.55 | 1.1 | 0.25 | — | — | 0.55 | — | 0.1 | 0.95 | | | | |
| 22 | 6.4 | — | — | 1.5 | — | 3.5 | — | 3.7 | 1.4 | | | | |
| 23 | 5.3 | 0.5 | 0.65 | — | — | — | — | 9.0 | 1.85 | | | | |
| 24 | 1.3 | 0.4 | 0.23 | 0.25 | — | — | — | — | 0.48 | | | 4.0% | Ni |
| 25 | 4.35 | 0.4 | 0.55 | 2.8 | 4.5 | 2.55 | — | 2.10 | 0.85 | 0.14 | 0.4 | | |
| 26 | 16.1 | — | — | 16.2 | — | 3.75 | — | 0.2 | | | | 58% | Ni |
| 27 | 21.5 | — | — | 9.0 | — | — | 3.65 | — | 0.05 | | | 0.2% | Ti |
| 28 | 19.0 | — | — | 3.05 | — | — | 5.13 | — | 0.04 | | | 52.5% | Ni |
| 29 | 18.0 | — | — | 3.0 | — | — | 5.0 | — | 0.02 | | | | |
| 30 | 1.9 | 1.5 | 0.4 | 0.2 | — | — | — | — | 0.4 | | | | |
| 31 | 2.0 | 1.5 | 0.3 | 0.2 | — | — | — | — | 0.38 | | | 1.1% | Ni |
| 32 | 17.5 | 0.4 | 0.45 | 1.1 | — | — | — | 0.1 | 0.9 | 0.27 | 1.1 | | |
| 33 | 16.2 | — | — | — | — | — | 0.34 | — | 0.04 | | | 4.0% | Ni |
| 34 | — | — | — | 5.0 | 8.8 | — | — | — | | | | 18.5 | Ni |
| 35 | 5.2 | 0.4 | 0.9 | 1.3 | — | — | — | 0.45 | 0.38 | | | | |
| 36 | 5.2 | 0.4 | 0.9 | 1.4 | — | — | — | 0.95 | 0.39 | 0.17 | 0.78 | | |
| 37 | 4.5 | 0.25 | 0.2 | 3.0 | — | — | — | 0.6 | 0.5 | | | | |
| 38 | 4.6 | 0.45 | 0.2 | 3.0 | — | — | — | 0.75 | 0.5 | | | | |
| 39 | — | — | — | 5.0 | 9.0 | — | — | — | — | | | 18.5% | Ni |
| 40 | — | — | — | 4.9 | 9.3 | — | — | — | — | | | 1.10% | Ti |

AA—referes to the sum of % Y + % Sc + % REE
* - in ppm.

Illustrative example of different natures tested for each single alloy overall composition following the strategies of examples 16 and 18:

Alloy 4 as a single gas atomized powder (D50=36 micron).

Alloy 4 as a mixture of 2 spherical powders —both with the composition of alloy 4-68% with a size D50=microns (centrifugally atomized) and 22% with a size of D50=5 microns (gas atomized).

Alloy 4 as a mixture: 72% of centrifugal atomized powder with the composition similar to alloy 4 without the % C (D10=150 micron), 18% of LC carbonyl iron (D50=11 micron), roughly 8.5% of fine gas atomized powder with the composition required to match an overall composition of alloy 4 without the % C (D90-18 micron) and roughly 1.5% C on the form of graphite powder (D50=20 microns)—The amount of graphite depending on the shaping method to be used as well as the processing methods of the present invention since there are many different ways to fix the % C—

Alloy 4 as a mixture: 57% of water atomized powder with the composition of Alloy 4 but without % C and % Mo and only half of % Cr and D50=270 microns, 4.5% of 80Cr20Fe ferro-alloy (D50=69 microns), 2.29% of 70Mo30Fe ferro-alloy (D50=64 microns), roughly 1.5% C on the form of graphite powder (D50=20 microns)—The amount of graphite depending on the shaping method to be used as well as the processing methods of the present invention since there are many different ways to fix the % C— 25% of LC carbonyl iron (D50=6 micron), and 9.71% of a centrifugally atomized powder with the required composition to match an overall composition of alloy 4 (D50=59 microns).

Alloy 4 as a mixture: 60% of water atomized iron powder with 1.6% Mo and D50=60 microns, 18% of carbonyl iron (D90=11 microns), roughly 1.5% C on the form of graphite powder (D50=20 microns)—The amount of graphite depending on the shaping method to be used as well as the processing methods of the present invention since there are many different ways to fix the % C— and 20.5% of a gas atomized powder with the required composition to match an overall composition of alloy 4 (D50=15 microns).

Etc.

Example 21. Several Steels were tested. The different strategies in terms of powder and powder mixtures described in this document were tested, amongst others all the strategies described in examples 16 and 18 were tested for every single overall composition in the table below. In particular many tests were performed incorporating iron carbonyl powders. In several tests incorporating mixes of powders of different size, carbonyl powder was used as one of the smaller powders. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of examples 16 and 18 at least one relevant characteristic was better in comparison to the exactly same composition melt in the LAB with a laboratory arc melting furnace—Edmund Bühler GmbH Arc Melter AM200—Also in most of the cases when following the strategies of example 16 (which incorporates all the strategies of example 18) and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| # | % Cr | % Mn | % Si | % Mo | % Co | % W | % Nb | % V | % C | % O* | AA | OTHERS |
|---|---|---|---|---|---|---|---|---|---|---|---|---|
| 1 | | 0.55 | | | | | | | 0.25 | 0.34 | 1.26 | |
| 2 | | 0.65 | | | | | | | 0.35 | | | |
| 3 | | 0.65 | | | | | | | 0.45 | | | |
| 4 | | 0.75 | | | | | | | 0.55 | | | |
| 5 | | 0.75 | | | | | | | 0.6 | 0.71 | 2.62 | |
| 6 | | <1.4 | | | | | | | <0.22 | | | P, S, N |
| 7 | | <1.6 | <0.55 | | | | | | <0.22 | | | P,S |
| 8 | 1.05 | 0.75 | | | | | | | 0.41 | | | |
| 9 | 1.05 | 0.75 | 0.22 | | | | | | 0.25 | 1.41 | 5.21 | |
| 10 | 1.05 | 0.75 | 0.22 | | | | | | 0.34 | | | |
| 11 | 1.05 | 0.75 | 0.22 | | | | | | 0.42 | | | |
| 12 | 1.05 | 0.75 | 0.22 | | | | | | 0.42 | | | S |
| 13 | 1.5 | 0.65 | 0.22 | | | | | | 0.34 | 1.34 | 4.98 | Ni 1.5 |
| 14 | 2.0 | 0.45 | 0.4 | | | | | | 0.3 | | | Ni 2.0 |
| 15 | 1.8 | 0.45 | 0.35 | | | | | | 0.36 | | | Ni 3.85 |
| 16 | 1.5 | 0.35 | 0.25 | | | | | | 1.0 | | | Al <0.05, |
| | | | | | | | | | | | | Cu |
| 17 | 1.55 | 1.10 | 0.6 | | | | | | 1.0 | 0.24 | 0.9 | Al <0.05, |
| | | | | | | | | | | | | Cu |
| 18 | 1.8 | 0.70 | 0.25 | 0.17 | | | | | 1.0 | | | Al <0.05, |
| | | | | | | | | | | | | Cu |
| 19 | | 0.65 | 1.65 | | | | | | 0.38 | | | Cu, Sn |
| 20 | 0.35 | 0.85 | 1.8 | | | | | | 0.61 | 0.67 | 2.47 | Cu, Sn |
| 21 | 0.85 | 0.85 | | | | | | | 0.55 | | | Cu, Sn |
| 22 | 1.05 | 0.9 | | | | | | 0.17 | 0.55 | | | Cu, Sn |
| 23 | 1.05 | 0.9 | | 0.22 | | | | 0.15 | 0.52 | 1.39 | 5.14 | Cu, Sn |
| 24 | 0.85 | 0.75 | | | | | | | 0.17 | | | |
| 25 | 0.95 | 1.15 | | | | | | | 0.16 | | | |
| 26 | 0.95 | 1.15 | | | | | | | 0.16 | 1.15 | 4.25 | S 0.03 |
| 27 | 1.15 | 1.25 | | | | | | | 0.20 | | | |
| 28 | 0.55 | 0.80 | | 0.2 | | | | | 0.20 | | | Ni 0.55 |
| 29 | 0.55 | 0.80 | | 0.2 | | | | | 0.20 | | | S 0.03, |
| | | | | | | | | | | | | Ni 0.55 |
| 30 | 0.75 | 0.55 | | | | | | | 0.17 | 0.72 | 2.67 | Ni 3.25 |
| 31 | 1.65 | 0.70 | | 0.3 | | | | | 0.18 | | | Ni 1.55 |
| 32 | 1.05 | 0.75 | | 0.2 | | | | | 0.18 | 0.53 | 1.98 | S 0.03 |
| 33 | 1.15 | 0.55 | | 0.2 | | | | | 0.34 | | | Al 1.00 |
| 34 | 1.65 | 0.55 | | 0.3 | | | | | 0.41 | | | Al 1.00 |
| 35 | 2.50 | 0.55 | | 0.2 | | | | 0.15 | 0.31 | 0.28 | 1.05 | |
| 36 | 1.65 | 0.55 | | 0.2 | | | | | 0.34 | | | Al 1.00, |
| | | | | | | | | | | | | Ni 1.00 |
| 37 | <0.11 | 1.10 | <0.05 | | | | | | <0.14 | 1.44 | 5.36 | P, S |
| 38 | <0.11 | 1.10 | <0.05 | | | | | | <0.14 | | | P. S, Pb |
| 39 | 0.04 | 1.40 | 0.50 | | | | | 0.14 | 0.19 | 1.14 | 5.24 | |
| 40 | 0.04 | 1.40 | 0.50 | | | | | 0.14 | 0.38 | | | |
| 41 | 0.04 | 1.40 | 0.50 | | | | | 0.14 | 0.46 | | | |
| 42 | | 1.30 | | | | | | | 0.30 | | | B 0.003 |
| 43 | 0.45 | 1.25 | | | | | | | 0.27 | 1.17 | 4.35 | B 0.003 |
| 44 | 0.45 | 1.35 | | | | | | | 0.33 | | | B 0.003 |

AA—referes to the sum of % Y + % Sc + % REE
* - in ppm.

Illustrative example of different natures tested for each single alloy overall composition following the strategies of examples 16 and 18: Alloy 4 as a single gas atomized powder (D50=120 micron).

Alloy 4 as a mixture of 2 spherical powders —both with the composition of alloy 4-52% with a size D50=35 microns (centrifugally atomized) and 48% with a size of D50=45 microns (gas atomized).

Alloy 4 as a mixture: 52% of oxide reduced iron powder (D10=450 micron), 18% of LC carbonyl iron (D50=12 micron), roughly 29.75% of quite-spherical high pressure water atomized powder with the composition required to match an overall composition of alloy 4 (090-32 micron) and roughly 0.25% C on the form of graphite powder (D50=20 microns)—The amount of graphite depending on the shaping method to be used as well as the processing methods of the present invention since there are many different ways to fix the % C—

Etc.

Example 22. Several Ultra High Strength iron based alloys were tested. The different strategies in terms of powder and powder mixtures described in this document were tested, amongst others all the strategies described in examples 16 and 18 wore tested for every single overall composition in the table below. In particular many tests were performed incorporating iron carbonyl powders. In several tests incorporating mixes of powders of different size, carbonyl powder was used as one of the smaller powders. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of examples 16 and 18 at least one relevant characteristic was better in comparison to the exactly same composition melt in the LAB with a laboratory arc melting furnace—Edmund Buhler GmbH Arc Melter AM200—Also in most of the cases when following the strategies of example 16 (which incorporates all the strategies of example 18) and either 3, 4, 8, 12, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| # | % Cr | % Mn | % Si | % Mo | % Co | % Ni | % Nb | % V | % C | % O* | AA | OTHERS | |
|---|---|---|---|---|---|---|---|---|---|---|---|---|---|
| 1 | 0.01 | 0.02 | 0.02 | 4.8 | 11.9 | 18.5 | — | — | 0.01 | | | | |
| 2 | 9.9 | — | — | 1.9 | 14.2 | 5.4 | — | 0.28 | 0.21 | 720 | 2.7 | | |
| 3 | 3.4 | — | — | 1.8 | 16.3 | 7.6 | — | 0.03 | 0.12 | | | | |
| 4 | 3.4 | — | — | 1.1 | 18.1 | 9.5 | — | 0.08 | 0.14 | | | | |
| 5 | 0.9 | — | — | 1.9 | 6.9 | 9.9 | — | 0.11 | 0.31 | 1160 | 4.3 | | |
| 6 | 23.0 | 1.0 | 0.5 | — | — | 60 | — | — | 0.1 | | | | |
| 7 | — | — | — | 3 | 8.0 | 17.0 | — | — | — | | | 0.15% | Ti |
| 8 | — | — | — | 3.5 | 9.0 | 19.0 | — | — | — | | | 0.25% | Ti |
| 9 | — | — | — | 4.6 | 7.0 | 17.0 | — | — | — | | | 0.3% | Ti |
| 10 | — | — | — | 5.2 | 8.5 | 19.0 | — | — | — | | | 0.5% | Ti |
| 11 | — | — | — | 4.6 | 8.5 | 18.0 | — | — | — | | | 0.5% | Ti |
| 12 | — | — | — | 5.2 | 9.5 | 19.0 | — | — | — | | | 0.8% | Ti |
| 13 | — | — | — | 4.6 | 11.5 | 18.0 | — | — | — | | | 1.3% | Ti |
| 14 | — | — | — | 5.2 | 12.5 | 19.0 | — | — | — | | | 1.6% | Ti |
| 15 | 1.25 | 0.75 | 0.65 | — | — | 0.5 | — | — | 0.27 | | | | |
| 16 | 1.0 | 0.5 | 0.75 | — | — | 1.0 | — | 0.1 | 0.2 | 200 | 0.8 | | |
| 17 | 5.0 | 0.75 | 0.3 | 1.4 | — | — | — | 0.5 | 0.4 | | | | |
| 18 | 3.75 | 0.3 | 0.5 | 5.0 | — | — | — | 0.5 | 0.8 | | | 5.5% | W |
| 19 | 4.0 | 0.3 | 0.45 | 8.0 | 0.25 | — | — | 1.0 | 0.8 | | | 0.25% | W |
| 20 | 13.0 | 0.5 | 0.5 | 0.5 | — | 2.0 | — | — | 0.2 | | | 3% | W |
| 21 | 11.5 | 1.35 | 0.5 | 2.75 | — | 0.5 | — | 0.25 | 0.3 | 320 | 1.2 | | |
| 22 | 17.5 | 1.0 | 1.0 | — | — | 5.0 | 0.45 | — | 0.07 | | | 5% | Cu |
| 23 | 16.5 | 1.25 | 0.5 | 1.25 | — | 5.0 | — | — | 0.11 | | | | |
| 24 | 17.5 | 1.0 | 1.0 | — | — | 7.5 | — | — | 0.08 | 940 | 3.5 | | |
| 25 | 16.0 | 1.75 | — | 6.0 | — | 25.0 | — | — | 0.05 | | | | |
| 26 | 15.9 | 0.75 | 0.5 | 2.5 | — | 14.1 | 0.45 | — | 0.12 | | | 0.25% | Ti |
| 27 | 24.0 | 3.6 | — | 7.3 | — | 22.0 | — | | 0.01 | | | 0.6% | Cu |
| 28 | 16.0 | 2.0 | 1.0 | 1.5 | — | 27.0 | — | 0.5 | — | | | 2.35% | Ti |
| 29 | 13.5 | 1.65 | 0.8 | 1.75 | — | 26.0 | — | — | 0.03 | | | 3% | Ti |

AA—referes to the sum of % Y + % Sc + % REE
* - in ppm.

Illustrative example of different natures tested for each single alloy overall composition following the strategies of examples 16 and 18:

Alloy 1 as a single gas atomized powder (D50=30 micron).

Alloy 1 as a mixture of 2 spherical powders —both with the composition of alloy 1-91% with a size D50=38 microns (centrifugally atomized) and 9% with a size of D50=42 microns (gas atomized).

Alloy 4 as a mixture. 70% of centrifugal atomized powder with the composition of Alloy 1 but with only 10% Ni and 7% Co (D10=˜ 20 micron), 5% of LC carbonyl iron (D50=2 micron), 25% of fine gas atomized powder with the composition required to match an overall composition of alloy 1 (D90=9 micron).

Etc.

Example 23. Several Hot Work Tool Steels wore tested. The different strategies in terms of powder and powder mixtures described in this document were tested, amongst others all the strategies described in examples 16 and 18 were tested for every single overall composition in the table below. In particular many tests were performed incorporating iron carbonyl powders. In several tests incorporating mixes of powders of different size, carbonyl powder was used as one of the smaller powders. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of examples 16 and 18 at least one relevant characteristic was better in comparison to the exactly same composition melt in the LAB with a laboratory arc melting furnace—Edmund Buhler GmbH Arc Melter AM200—Also in most of the cases when following the strategies of example 16 (which incorporates all the strategies of example 18) and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| # | % Cr | % Mn | % Si | % Mo | % Co | % W | % Nb | % V | % C | % O* | AA | OTHERS | |
|---|---|---|---|---|---|---|---|---|---|---|---|---|---|
| 1 | 4.5 | — | — | 1.0 | — | — | — | 0.2 | 0.35 | 555 | 2.1 | | |
| 2 | 5.0 | 0.3 | 1.0 | 1.1 | — | — | 0.1 | 0.4 | 0.4 | 260 | 0.1 | | |
| 3 | 2.6 | 0.2 | 0.3 | 1.2 | — | — | 0.1 | 0.3 | 0.42 | 1430 | 5.3 | | |
| 4 | 4.96 | 0.35 | 1.1 | 1.18 | — | — | — | 0.44 | 0.39 | — | | | |
| 5 | 5.0 | 0.4 | 1.1 | 1.3 | — | — | — | 0.4 | 0.38 | | | | |
| 6 | 5.2 | 0.4 | 1.1 | 1.3 | — | — | — | 0.95 | 0.39 | | | | |
| 7 | 5.2 | 0.4 | 0.4 | 2.8 | — | — | — | 0.55 | 0.38 | | | | |
| 8 | 2.9 | 0.35 | 0.3 | 2.8 | — | — | — | 0.5 | 0.31 | 1620 | 0.6 | | |
| 9 | 5.0 | 0.55 | 0.2 | 1.75 | — | — | — | 0.55 | 0.38 | | | | |
| 10 | 4.5 | 0.25 | 0.2 | 3.0 | — | — | — | 0.55 | 0.5 | | | | |
| 11 | 5.0 | 0.25 | 0.2 | 1.3 | — | — | — | 0.45 | 0.37 | | | | |
| 12 | 5.0 | 0.25 | 0.2 | 2.8 | — | — | — | 0.65 | 0.38 | 1215 | 0.45 | | |
| 13 | — | 0.1 | 0.05 | 5.0 | 9.0 | — | — | — | 0.01 | | | 0.7% | Ti |
| 14 | — | 0.05 | 0.05 | 4.9 | 9.3 | — | — | — | 0.01 | | | 1.0% | Ti |
| 15 | 1.9 | 1.5 | 0.4 | 0.2 | — | — | — | — | 0.4 | | | | |
| 16 | 2.0 | 1.5 | 0.3 | 0.2 | — | — | — | — | 0.38 | 785 | 0.29 | | |
| 17 | 2.0 | 1.5 | 0.3 | 0.2 | — | — | — | — | 0.38 | | | 1.1% | Ni |
| 18 | 0.35 | 2.0 | 0.3 | — | — | — | — | — | 0.13 | | | 3.5% | Ni |
| 19 | 2.0 | 1.8 | 0.2 | 0.3 | — | — | — | — | 0.36 | 920 | 0.34 | | |
| 20 | 5.3 | 0.4 | 1.0 | 1.3 | — | — | — | 0.9 | 0.39 | | | | |
| 21 | 2.6 | 0.75 | 0.3 | 2.25 | — | — | — | 0.9 | 0.38 | | | | |
| 22 | 5.0 | 0.5 | 0.2 | 2.3 | — | — | — | 0.6 | 0.35 | | | | |
| 23 | 5.2 | 0.4 | 1.0 | 1.4 | — | — | — | 0.9 | 0.39 | 1375 | 0.51 | | |
| 24 | 5.2 | 0.4 | 1.0 | 1.3 | — | — | — | 0.9 | 0.41 | | | | |
| 25 | 5.2 | 0.6 | 0.3 | 2.7 | — | — | — | 0.9 | 0.35 | | | | |
| 26 | 5.2 | 0.6 | 0.2 | 2.2 | — | — | — | 0.8 | 0.4 | | | 0.6% | Ni |
| 27 | 5.1 | 0.6 | 0.3 | 1.6 | — | — | — | 0.7 | 0.42 | | | 0.6% | Ni |
| 28 | 4.3 | 0.5 | 0.5 | 2.1 | — | 0.7 | — | 0.9 | 0.4 | 2100 | 0.78 | | |
| 29 | 3.4 | 0.9 | 0.3 | 2.5 | — | — | — | 0.6 | 0.39 | | | 0.9% | Ni |
| 30 | 4.4 | 0.5 | 0.3 | 1.6 | — | 2.0 | — | 1.7 | 0.51 | | | | |
| 31 | 5.2 | 0.7 | 1.0 | 1.3 | — | — | — | 0.4 | 0.3 | 570 | 0.21 | | |
| 32 | 1.3 | 0.9 | 0.3 | 0.4 | — | — | — | 0.2 | 0.51 | | | 1.8% | Ni |
| 33 | 4.2 | 0.5 | 0.2 | 2.0 | — | 1.6 | — | 1.2 | 0.49 | | | | |
| 34 | 3.0 | 0.15 | 0.15 | — | — | 8.5 | — | 0.3 | 0.26 | | | | |
| 35 | 3.75 | 0.4 | 0.5 | — | — | 10 | — | 0.6 | 0.36 | 1430 | 0.53 | | |
| 36 | 4.0 | 0.2 | 0.2 | 0.3 | 4.0 | 3.75 | — | 1.75 | 0.32 | | | | |
| 37 | 4.75 | 0.5 | 0.5 | 0.55 | 4.5 | 4.5 | — | 2.2 | 0.45 | | | | |
| 38 | 1.1 | 0.75 | 0.25 | 0.45 | — | — | — | 0.1 | 0.32 | | | 1.65% | Ni |
| 39 | 13.0 | 0.7 | 1.35 | — | — | 2.15 | — | 0.6 | 0.5 | | | 13% | Ni |

AA—referes to the sum of % Y + % Sc + % REE
* - in ppm.

Illustrative example of different natures tested for each single alloy overall composition following the strategies of examples 16 and 18:

Alloy 4 as a single gas atomized powder with a +5/−50 micron distribution (D50=38 micron).

Alloy 4 as a mixture of 2 gas atomized powders —both with the composition of alloy 4-73% with a size D50=120 microns and 27% with a size of D50=15 microns.

Alloy 4 as a mixture. 73% of centrifugal atomized powder with the composition similar to alloy 4 without the % C (D10=˜ 70 micron), 20% of LC carbonyl iron (D50=4 micron), roughly 6.5% of fine gas atomized powder with the composition required to match an overall composition of alloy 4 without the % C (D90=10 micron) and roughly 0.5% C on the form of graphite powder (D50=20 microns)—The amount of graphite depending on the shaping method to be used as well as the processing methods of the present invention since there are many different ways to fix the % C—

Alloy 4 as a mixture: 53% of water atomized powder with the composition of Alloy 4 but without % C and % Cr and D50=100 microns, 6.25% of 80Cr20Fe ferro-alloy (D50=69 microns), 0.6% graphite powder (D50=20 microns) and 40.15% of a gas atomized powder with the required composition to match an overall composition of alloy 4 (D50=15 microns).

Alloy 4 as a mixture, 60% of water atomized iron powder with 1.6% Mo and D50=120 microns, 20% of carbonyl iron (D90=11 microns). 0.6% graphite powder (D50=20 microns) and 19.4% of a gas atomized powder with the required composition to match an overall composition of alloy 4 (D50=15 microns).

Alloy 4 as a mixture: 60% of water atomized powder with the composition similar to alloy 4 without the %/C and D50=120 microns, 34.4% of carbonyl iron (D90=11 microns), 0.6% graphite powder (D50=20 microns) and 5% of a gas atomized powder with the required composition to match an overall composition of alloy 4 (1050=15 microns).

Etc.

Example 24. Several titanium base alloys were tested. The different strategies in terms of powder and powder mixtures described in this document were tested, amongst others all the strategies described in example 18 were tested for every single overall composition in the table below. In particular many tests were performed incorporating pure titanium powders. In several tests incorporating mixes of powders of different size, pure titanium powder was used as one of the smaller powders. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of example 18 at least one relevant characteristic was better in comparison to the exactly same composition melt in the LAB with a laboratory arc melting furnace—Edmund Bühler GmbH Arc Melter AM200—Also in most of the cases when following the strategies of example 18 and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| # | % V | % Mo | % Cr | % Sn | % Al | % Mn | % Zr | % Cu | % Nb | % Fe | AA | OTHERS | |
|---|---|---|---|---|---|---|---|---|---|---|---|---|---|
| 1 | 4.1 | — | — | — | 6.2 | — | — | — | — | 0.2 | | 3.9 % | W |
| 2 | 5.1 | — | — | 2.4 | 4.8 | — | — | 1.1 | — | 0.2 | 1.4 | 0.3% | O |
| 3 | 3.9 | — | — | 0.01 | 6.3 | — | — | — | — | 0.1 | 1.1 | 0.28 % | O |
| 4 | — | — | — | 2.0 | 4.0 | — | — | — | — | 0.5 | | | |
| 5 | — | — | — | 3.0 | 6.0 | — | — | — | — | 0.3 | | | |
| 6 | 3.5 | — | — | — | 6.75 | — | — | — | — | 0.3 | | 0.08% | C |
| 7 | 4.5 | — | — | — | 5.5 | — | — | — | — | 0.3 | | 0.05% | N |
| 8 | 3.75 | — | — | — | 5.8 | — | — | — | — | 0.4 | | 0.01% | H |
| 9 | 3.8 | — | — | — | 5.6 | — | — | — | — | 0.25 | | | |
| 10 | 5.0 | — | — | 2.5 | 4.9 | — | — | 1.0 | — | 1.0 | | | |
| 11 | 6.0 | — | — | 1.5 | 6.1 | — | — | 0.35 | — | 0.35 | | 0.04% | N |
| 12 | — | 2.2 | — | 2.2 | 6.5 | — | 4.4 | — | — | 0.25 | | 0.05% | C |
| 13 | — | 1.8 | — | 1.8 | 5.5 | — | 3.6 | — | — | 0.2 | | 0.04% | N |
| 14 | — | 1.9 | — | 2.0 | 5.8 | — | 3.9 | — | — | 0.23 | 0.8 | 0.21% | O |
| 15 | 8.4 | 4.5 | 6.5 | — | 4.0 | — | 4.5 | — | — | 0.3 | | | |
| 16 | 7.6 | 3.5 | 5.5 | — | 3.0 | — | 3.5 | — | — | 0.27 | | | |
| 17 | 8.0 | 3.9 | 5.8 | — | 3.4 | — | 3.8 | — | — | 0.2 | 0.3 | 0.11% | O |
| 18 | — | 0.25 | 1.2 | — | 2.7 | 1.1 | — | — | — | 1.7 | | | |
| 19 | — | 0.15 | 0.75 | — | 2.1 | 0.65 | — | — | — | 2.3 | | | |
| 20 | — | 0.65 | 1.5 | — | 3.2 | 0.65 | 0.3 | — | — | 0.8 | 1.2 | 0.3% | O |
| 21 | — | — | — | — | — | — | — | 2.8 | — | 0.2 | | | |
| 22 | — | 1.75 | — | 2.25 | 6.5 | — | 3.5 | — | — | 0.25 | | 0.05% | N |
| 23 | — | 2.25 | — | 1.75 | 5.5 | — | 4.5 | — | — | 0.2 | | | |
| 24 | 2.0 | — | — | — | 2.5 | — | — | — | — | 0.15 | | 0.03% | N |
| 25 | 3.0 | — | — | — | 3.5 | — | — | — | — | 0.2 | | 0.015% | H |
| 26 | — | 1.0 | — | 2.5 | 6.0 | — | 1.5 | — | — | 1.3 | 2.5 | 0.45% | O |
| 27 | — | 0.8 | — | — | 6.1 | — | — | — | 2.0 | 0.12 | | 1% | Ta |
| 28 | — | 0.4 | — | — | 5.3 | — | — | — | 2.3 | 0.15 | | 1.3% | Ta |

AA—referes to the sum of % Y + % Sc + % REE

Illustrative example of different natures tested for each single alloy overall composition following the strategies of example 18:

Alloy 3 as a single gas atomized powder with a +5/−25 micron distribution (D50=19 micron).

Alloy 3 as a mixture, 73% of gas atomized powder with the composition similar to alloy 3 but with less than 0.1% O (D50=154 microns), 20% of plasma atomized pure titanium spherical powder (D50=21 microns) and 7% of plasma atomized powder with the composition required to match an overall composition of alloy 3 except for the % C. The powder was oxidized in a controlled way at low temperature to attain the %0 level of alloy 3.

Etc.

Example 25. Several nickel base alloys were tested. The different strategies in terms of powder and powder mixtures described in this document were tested, amongst others all the strategies described in example 18 were tested for every single overall composition in the table below. In particular many tests were performed incorporating nickel carbonyl powders. In several tests incorporating mixes of powders of different size, carbonyl powder was used as one of the smaller powders. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of example 18 at least one relevant characteristic was better in comparison to the exactly same composition melt in the LAB with a laboratory arc melting furnace—Edmund Bühler GmbH Arc Melter AM200—Also in most of the cases when following the strategies of example 18 and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated. In this case, oxidation was challenging and strategies incorporating the % O as oxides were preferred—although the ones with direct oxidation were also almost implemented-.

| # | % Fe | % Cu | % Si | % Mo | % Co | % Cr | % Nb | % Mn | % Al | % Zn | AA | OTHERS | |
|---|---|---|---|---|---|---|---|---|---|---|---|---|---|
| 1 | 5.6 | — | 0.04 | 15.8 | 1.2 | 15.7 | — | 0.35 | — | — | | 3.9% | W |
| 2 | 19.2 | 0.01 | 0.1 | 3.2 | 0.05 | 19.5 | 5.2 | 0.15 | 0.7 | — | | 0.92% | Ti |
| 3 | 20.1 | — | — | 2.9 | — | 20.1 | 4.9 | — | 0.6 | — | 0.3 | 008% | O |
| 4 | 39.5 | 0.01 | 0.15 | 3.2 | — | 21.3 | — | — | 0.15 | — | | | |
| 5 | 30.6 | 1.7 | 0.35 | 3.2 | — | 23 | — | 0.8 | 0.1 | — | | 0.01% | C |
| 6 | 6.0 | — | 0.08 | 14.5 | 2.5 | 21.4 | — | 0.5 | 0.6 | — | | | |
| 7 | 6.3 | — | — | 13.2 | 2.3 | 21.1 | — | 0.7 | 0.7 | — | 2.1 | 0.56% | O |
| 8 | 3.0 | — | 0.08 | 17.0 | 2.0 | 16.4 | — | 1.0 | — | — | | | |
| 9 | 7.8 | 0.2 | 0.1 | 22.6 | 3.0 | 3.0 | 0.2 | 3.0 | 0.5 | | | 3.0% | W |
| 10 | 5.3 | 0.01 | 0.5 | 9.2 | — | 20.1 | | 0.5 | | 0.4 | | | |
| 11 | 5.1 | — | — | 8 | — | 23.0 | — | — | — | | 0.9 | 0.20% | O |
| 12 | 6.0 | 0.3 | 0.08 | 12.8 | 2.5 | 21.3 | — | 0.5 | — | — | | | |
| 13 | 2.0 | — | — | 14.5 | — | 22.5 | — | — | — | — | | 0.01% | C |
| 14 | 1.3 | — | 0.1 | 30.0 | 1.0 | 1.0 | — | 1.0 | — | — | | 0.02% | C |
| 15 | 2.0 | — | — | 26.0 | — | — | — | — | — | — | 0.5 | 0.12% | O |
| 16 | 0.4 | 0.02 | 0.07 | 9.0 | — | 22.0 | 3.6 | 0.01 | 0.1 | — | | | |
| 17 | 5.2 | 0.2 | 0.96 | 1.3 | — | 16.1 | 0.05 | 0.2 | — | — | | 3.4% | W |
| 18 | 1.0 | 0.01 | 0.01 | 16.2 | 0.5 | 20.6 | — | — | 0.2 | — | | 3.9% | W |
| 19 | 0.5 | 0.2 | 0.1 | 9.0 | 12.3 | 22.0 | — | — | 1.0 | | | 0.3% | Ti |
| 20 | 0.2 | 0.14 | — | 8.3 | 11.7 | 25.0 | — | — | — | — | 4 | 1.0% | O |
| 21 | 1.2 | 29.0 | 0.2 | 0.6 | 0.3 | 0.8 | — | 3.2 | 0.1 | | | 2.2% | Ti |
| 22 | 8.6 | 0.01 | 0.2 | 0.01 | — | 29.7 | 0.75 | 0.4 | 0.25 | — | | 0.45% | Ti |
| 23 | 7.0 | — | — | — | — | 30.6 | — | — | — | | | 2.56% | Ti |
| 24 | 18.5 | 0.5 | 1.0 | 8.5 | 1.0 | 21.3 | — | 0.5 | 0.1 | — | | 0.5% | W |
| 25 | 18.4 | 0.3 | 0.6 | 8.1 | — | 22.5 | — | — | — | | 3.4 | 0.9% | O |
| 26 | 20.5 | 0.05 | 0.15 | 3.0 | 0.2 | 17.5 | 5.0 | 0.1 | 0.4 | — | | | |
| 27 | 20.8 | — | — | 3.2 | — | 17.3 | 4.75 | — | — | — | 0.7 | 0.15% | O |
| 28 | 7.3 | 0.01 | 0.02 | 0.05 | 0.04 | 16.7 | — | 2.4 | — | — | | | |
| 29 | 1.3 | 0.02 | 0.1 | 0.01 | 0.05 | 20.5 | 2.4 | 3.1 | — | — | | 0.03% | C |
| 30 | 1.2 | — | — | — | — | 22.3 | 2.8 | 4.25 | — | — | 1.9 | 0.5% | O |
| 31 | 1.5 | 0.5 | 0.1 | 16.0 | — | 23.0 | — | 0.5 | 0.4 | — | | | |
| 32 | 13.3 | 0.01 | 0.24 | 0.01 | — | 22.8 | — | 0.55 | 1.4 | — | | 0.04% | C |
| 33 | 1.1 | 0.3 | 0.3 | 0.5 | 1.0 | 30.8 | 0.8 | 0.5 | 1 | — | | 0.7% | Ti |
| 34 | 1.0 | — | — | 0.5 | 0.9 | 30.3 | 0.4 | 0.2 | 0.8 | — | 4.3 | 1.1% | O |

AA—referes to the sum of % Y + % Sc + % REE

Illustrative example of different natures tested for each single alloy overall composition following the strategies of example 18:

Alloy 2 as a single gas atomized powder with a +10/−45 micron distribution (D50=32 micron).

Alloy 2 as a mixture of 2 gas atomized powders —both with the composition of alloy 2-73% with a size D50=80 microns and 27% with a size of D50=10 microns.

Alloy 2 as a mixture, 73% of gas atomized powder with the composition similar to alloy 2, 10% of carbonyl nickel and 17% of gas atomized powder with the composition required to match an overall composition of alloy 2

Alloy 2 as a mixture: 60% of water atomized powder with the composition of Alloy 2 but without % Ti and % Al and D50=150 microns. 1.4% of 50Ni50Al master-alloy (D50=40 microns). 9.2% of 10Ti90Al master —alloy and 29.4% of a gas atomized powder with the required to match an overall composition of alloy 2 (D50=30 microns).

Etc.

Example 26. Several copper base alloys were tested. The different strategies in terms of powder and powder mixtures described in this document were tested, amongst others all the strategies described in example 18 were tested for every single overall composition in the table below. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of example 18 at least one relevant characteristic was better in comparison to the exactly same composition melt in the LAB with a laboratory arc melting furnace—Edmund Bühler GmbH Arc Melter AM200—Also in most of the cases when following the strategies of example 18 and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated. In this case, oxidation was challenging and strategies incorporating the % O as oxides were preferred.

| # | % Ni | % Zn | % Al | % Sn | % Fe | % Si | % Pb | % Co | % Be | % Mn | AA | OTHERS | |
|---|---|---|---|---|---|---|---|---|---|---|---|---|---|
| 1 | — | 3.0 | — | — | 0.05 | — | 0.05 | — | — | — | | | |
| 2 | — | 6.0 | — | — | 0.03 | — | 0.01 | — | — | — | | | |
| 3 | — | 10 | — | — | — | — | — | — | — | 0.05 | | | |
| 4 | — | 8.7 | — | — | — | — | — | — | — | 0.08 | | | |
| 5 | — | 9.2 | — | — | — | — | — | — | — | 0.06 | 1.2 | 0.3% | O |
| 6 | — | 0.3 | — | 4.9 | 0.1 | — | 0.05 | — | — | — | | | |
| 7 | — | 0.24 | — | 3.5 | 0.05 | — | 0.04 | — | — | — | | | |
| 8 | — | 3.5 | — | 4.5 | 0.1 | — | 4.0 | — | — | — | | 0.5% | P |
| 9 | — | 1.5 | — | 3.5 | 0.08 | — | 3.0 | — | — | — | | 0.01% | P |
| 10 | — | 0.3 | — | 4.2 | 0.1 | — | 0.05 | — | — | — | | | |
| 11 | — | 0.24 | — | 5.8 | 0.03 | — | — | — | — | — | 0.5 | 0.12% | O |
| 12 | — | 14.2 | 3.0 | 0.5 | 2.0 | — | 0.2 | — | — | 2.5 | | | |
| 13 | — | 13.6 | 6.0 | 0.34 | 4.0 | — | 0.05 | — | — | 5.0 | | | |
| 14 | — | 13.8 | 4.3 | 0.41 | 3.1 | — | — | — | — | 3.2 | 2.3 | 0.6% | O |
| 15 | — | 30.2 | — | 0.5 | 0.4 | — | 0.5 | — | — | 0.05 | | | |
| 16 | — | 34.3 | — | 1.5 | 1.3 | — | 1.0 | — | — | 0.5 | | | |
| 17 | — | 0.2 | 7.0 | — | 1.5 | — | 0.01 | — | — | 1.0 | | 0.015% | P |
| 18 | — | 0.25 | 8.2 | — | 3.5 | — | 0.05 | — | — | 1.3 | | | |
| 19 | 4.0 | 0.01 | 8.7 | — | 3.5 | 0.1 | 0.02 | — | — | 1.2 | | | |
| 20 | 4.8 | 0.05 | 9.5 | — | 4.3 | — | — | — | — | 2.0 | 0.8 | 0.16% | O |
| 21 | — | — | 0.2 | — | 0.05 | 0.2 | — | 0.2 | 1.8 | — | | | |
| 22 | — | — | 0.13 | 0.01 | 0.03 | 0.15 | — | 0.36 | 2.0 | — | | | |
| 23 | 0.1 | — | 0.2 | — | 0.3 | 0.2 | — | 0.2 | 1.3 | — | | | |
| 24 | 0.2 | — | 0.14 | — | 0.4 | 0.1 | — | 0.3 | 2.4 | — | 3.2 | 0.9% | O |
| 25 | 16.5 | 20.8 | — | — | 0.25 | — | 0.05 | — | — | 0.5 | | | |
| 26 | 19.5 | 24.8 | 0.05 | — | 0.2 | — | 0.08 | — | — | 0.36 | | | |
| 27 | — | — | 1.5 | 1.0 | 2.5 | 4.0 | — | — | — | 1.5 | | | |
| 28 | — | — | 2.5 | 0.8 | 1.5 | 3.6 | — | — | — | 1.0 | | | |
| 29 | — | 2 | — | 10 | — | — | 0.3 | — | — | — | | | |
| 30 | — | 0.5 | — | 11 | — | — | 0.5 | — | — | — | 0.65 | 0.13% | O |
| 31 | 12.0 | 20.3 | — | 2.3 | — | — | 10.0 | — | — | — | | | |
| 32 | 20.5 | 8.1 | — | 4.6 | — | — | 4.3 | — | — | — | | | |
| 33 | 25.3 | 2.7 | — | 5.1 | — | — | 2.3 | — | — | — | 1.9 | 0.5% | O |
| 34 | 1.0 | 4.1 | 0.05 | 4.2 | 0.3 | 0.05 | 4.2 | — | — | — | | 0.25% | Sb |
| 35 | 0.6 | 3.9 | 0.02 | 3.7 | 0.24 | — | 6.2 | — | — | — | | 0.05% | P |
| 36 | 0.74 | 5.7 | — | 4.1 | 0.32 | — | 5.3 | — | — | — | 3.7 | 1.0% | O |

AA—referes to the sum of % Y + % Sc + % REE

Illustrative example of different natures tested for each single alloy overall composition following the strategies of example 18:

Alloy 8 as a single plasma atomized powder with a +40/−150 micron distribution (D50=84 micron).

Alloy 8 as a mixture of 2 centrifugal atomized powders —both with the composition of alloy 8-80% with a size D50=830 microns and 20% with a size of D50=0.6 microns.

Alloy 8 as a mixture: 45% of crushed powder with the composition of Alloy 8 and D50=1100 microns, 20% of pure copper high pressure water atomized powder (D50=80 microns), 25% of a centrifugal atomized powder with the required composition to match an overall composition of alloy 8 (D50=7 microns).

Etc.

Example 27. Several cobalt base alloys were tested. The different strategies in terms of powder and powder mixtures described in this document were tested, amongst others all the strategies described in example 18 were tested for every single overall composition in the table below. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of example 18 at least one relevant characteristic was better in comparison to the exactly same composition melt in the LAB with a laboratory arc melting furnace—Edmund Bühler GmbH Arc Melter AM200—Also in most of the cases when following the strategies of example 18 and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated. In this case, oxidation was challenging and strategies incorporating the % O as oxides were preferred.

| # | % Cr | % W | % Mo | % C | % Fe | % Si | % Ni | % V | % Nb | % Mn | AA | OTHERS | |
|---|---|---|---|---|---|---|---|---|---|---|---|---|---|
| 1 | 20.1 | 12.9 | — | 0.05 | 0.01 | 0.2 | 20.3 | — | — | 0.01 | | | |
| 2 | 24.0 | 15.9 | — | 0.02 | 3.0 | 0.5 | 23.9 | — | — | 1.25 | | 0.12% | La |
| 3 | 22.5 | 13.7 | — | 0.03 | 2.1 | 0.34 | 22.5 | — | — | 0.7 | 1.3 | 0.35% | O |
| 4 | 18.7 | 14.2 | — | 0.05 | 0.02 | 0.01 | 8.9 | — | — | 1.0 | | | |
| 5 | 21.2 | 16.7 | — | 0.15 | 3.2 | 0.45 | 11.7 | — | — | 2.0 | | | |
| 6 | 20.4 | 15.3 | — | 0.07 | 1.64 | 0.23 | 10.4 | — | — | 1.45 | 0.8 | 0.2% | O |
| 7 | 27.0 | 3.5 | 1.5 | 0.9 | 3.0 | 1.5 | 3.0 | — | — | 1.0 | | | |
| 8 | 31.1 | 5.5 | 1.4 | 1.4 | 2.7 | 1.3 | 2.8 | — | — | 0.9 | | | |
| 9 | 29.3 | 4.6 | — | 1.2 | — | — | — | — | — | — | 3.1 | 0.8% | O |
| 10 | 30.2 | 4.3 | 1.6 | 1.3 | 3.6 | 2.0 | 3.7 | — | — | 2.0 | | | |
| 11 | 23.2 | 11.1 | — | 1.8 | 2.0 | 0.8 | 3.0 | — | — | 0.5 | | | |
| 12 | 26.3 | 13.2 | — | 2.5 | 0.05 | 1.5 | 0.08 | — | — | 0.01 | | | |
| 13 | 24.7 | 12.1 | — | 2.2 | 1.4 | 1.2 | 0.16 | — | — | 0.32 | 0.5 | 0.12% | O |
| 14 | 26.3 | — | 4.5 | 0.2 | 0.05 | 0.05 | 2.0 | — | — | — | | | |
| 15 | 29.1 | — | 6.0 | 0.35 | 3.0 | 1.5 | 3.0 | — | — | — | | | |
| 16 | 28.3 | 0.01 | 5.7 | 0.28 | 2.4 | 1.1 | 2.4 | — | — | 0.05 | 2.3 | 0.52% | O |
| 17 | 24.5 | 6.9 | — | 0.45 | 0.06 | 0.07 | 9.5 | — | — | 0.04 | | | |
| 18 | 26.5 | 8.1 | — | 0.55 | 2.0 | 1.0 | 11.5 | — | — | 1.0 | 4.3 | 1.0% | O |
| 19 | 0.05 | 0.05 | — | 0.02 | 1.3 | 0.5 | 3.2 | 1.7 | — | 0.8 | | | |
| 20 | 1.3 | 1.2 | — | 0.5 | 2.0 | 1.0 | 4.6 | 2.1 | — | 1.0 | | | |
| 21 | 19.0 | — | 1.2 | 0.02 | 3.0 | 0.4 | 20.3 | — | 2.2 | 5.0 | | | |
| 22 | 20.3 | — | 2.3 | 0.8 | 5.6 | 1.0 | 24.1 | — | 3.1 | 7.2 | 0.8 | 0.2% | O |

AA—referes to the sum of % Y + % Sc + % REE

Illustrative example of different natures tested for each single alloy overall composition following the strategies of example 18:

Alloy 3 as a single high pressure water atomized powder with a +10; −50 micron distribution (D50=32 micron).

Alloy 3 as a mixture of 1 centrifugal atomized powder and 1 gas atomized powder —both with the composition of alloy 3-50% with a size D50-180 microns and 50% with a size of D50=240 microns.

Alloy 3 as a mixture, 55% of water atomized powder with the composition of Alloy 3 and D50=410 microns, 10% of pure cobalt crushed powder (D50=380 microns), 35% of a centrifugal atomized powder with the required composition to match an overall composition of alloy 3 (D50=45 microns).

Etc.

Example 28. Several Aluminum base alloys were tested. The different strategies in terms of powder and powder mixtures described in this document were tested, amongst others all the strategies described in example 18 were tested for every single overall composition in the table below. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of example 18 at least one relevant characteristic was better in comparison to the exactly same composition melt in the LAB with a laboratory arc melting furnace—Edmund Bühler GmbH Arc Melter AM200—Also in most of the cases when following the strategies of example 18 and either 3, 4, 8, 12, 13, 14 or 15 better toughness related performance that equivalent materials additively manufactured were attained. That was always the case when the strategies of example 8 were incorporated—even more so when the Pressure and for Temperature treatment was done incorporating the strategies described in example 9. That was always also the case when the strategies of example 10 were incorporated.

| # | % Mg | % Si | % Mn | % Ti | % Cr | % Fe | % Ni | % Cu | % Zn | % Sn | AA | OTHERS |
|---|---|---|---|---|---|---|---|---|---|---|---|---|
| 1 | 0.7 | 0.5 | 0.2 | | | 0.8 | | 0.3 | 0.2 | | 1.44 | 0.39% O |
| 2 | ≤0.05 | | ≤0.05 | ≤0.05 | — | ≤0.40 | — | ≤0.05 | ≤0.07 | — | | |
| 3 | — | | ≤0.05 | ≤0.05 | — | — | — | ≤0.05 | ≤0.10 | — | | |
| 4 | 0.4 | | 0.5 | ≤0.20 | ≤0.10 | ≤0.80 | ≤0.20 | 3.3 | ≤0.80 | ≤0.20 | | |
| 5 | 1.8 | | 1.0 | ≤0.20 | ≤0.10 | ≤0.80 | ≤0.20 | 4.6 | ≤0.80 | ≤0.20 | 2.98 | 0.8% O, |
| | | | | | | | | | | | | Pb, Sn, Bi |
| 6 | — | | — | — | — | ≤0.70 | — | 5.0 | ≤0.30 | — | | Pb, Sn, Bi |
| 7 | 0.2 | | 0.4 | ≤0.15 | ≤0.10 | ≤0.70 | — | 3.9 | ≤0.25 | — | | |
| 8 | 0.8 | | 1.2 | ≤0.15 | ≤0.10 | ≤0.70 | — | 5.0 | ≤0.25 | — | | |
| 9 | 0.2 | | 0.4 | ≤0.15 | ≤0.10 | ≤0.50 | ≤0.10 | 3.9 | ≤0.25 | — | 3.87 | 1.04% O |
| 10 | 0.8 | | 1.2 | ≤0.15 | ≤0.10 | ≤0.50 | ≤0.10 | 5.0 | ≤0.25 | — | | |
| 11 | 0.4 | | 0.4 | — | ≤0.10 | ≤0.70 | — | 3.5 | ≤0.25 | — | | |
| 12 | 1.0 | | 1.0 | — | ≤0.10 | ≤0.70 | — | 4.5 | ≤0.25 | — | | |
| 13 | 1.2 | | 0.3 | ≤0.15 | ≤0.10 | ≤0.50 | — | 3.8 | ≤0.25 | — | 5.42 | 1.46% O |
| 14 | 1.8 | | 0.9 | ≤0.15 | ≤0.10 | ≤0.50 | — | 3.8 | ≤0.25 | | | |
| 15 | 0.5 | | 0.2 | ≤0.20 | ≤0.10 | ≤0.70 | — | 3.3 | ≤0.50 | — | | Bi, Pb |
| 16 | 1.3 | | 1.0 | ≤0.20 | ≤0.10 | ≤0.70 | — | 3.3 | ≤0.50 | | | |
| 17 | — | | 1.0 | — | — | ≤0.70 | — | 0.05 | ≤0.10 | — | 4.63 | 1.25% O |
| 18 | 0.8 | | 1.0 | — | — | ≤0.70 | — | ≤0.25 | ≤0.25 | — | | |
| 19 | 1.3 | | 1.5 | — | — | ≤0.70 | — | ≤0.25 | ≤0.25 | — | | |
| 20 | 0.2 | | 1.0 | ≤0.10 | ≤0.10 | ≤0.70 | — | ≤0.30 | ≤0.25 | — | | |
| 21 | 0.6 | | 1.5 | ≤0.10 | ≤0.10 | ≤0.70 | — | ≤0.30 | ≤0.25 | — | 0.25 | 0.06% O |
| 22 | ≤0.30 | | 0.9 | — | ≤0.10 | ≤0.70 | — | ≤0.10 | ≤0.20 | — | | |
| 23 | ≤0.30 | | 1.5 | — | ≤0.10 | ≤0.70 | — | ≤0.10 | ≤0.20 | — | | |
| 24 | 0.2 | | 0.3 | ≤0.10 | ≤0.20 | ≤0.70 | — | ≤0.30 | ≤0.40 | — | | |
| 25 | 0.8 | | 0.8 | ≤0.10 | ≤0.20 | ≤0.70 | — | ≤0.30 | ≤0.40 | — | 1.05 | 0.28% O |
| 26 | 0.5 | | ≤0.20 | — | ≤0.10 | ≤0.70 | — | ≤0.20 | ≤0.25 | — | | |
| 27 | 1.1 | | ≤0.20 | — | ≤0.10 | ≤0.70 | — | ≤0.20 | ≤0.25 | — | | |
| 28 | 0.7 | | ≤0.15 | — | ≤0.10 | ≤0.45 | — | ≤0.05 | ≤0.20 | — | | |
| 29 | 1.1 | | ≤0.15 | — | ≤0.10 | ≤0.45 | — | ≤0.05 | ≤0.20 | — | 3.09 | 0.83% O |
| 30 | 1.6 | | 0.5 | ≤0.1 | ≤0.30 | ≤0.50 | — | ≤0.10 | ≤0.20 | — | | |
| 31 | 2.5 | | 1.1 | ≤0.1 | ≤0.30 | ≤0.50 | — | ≤0.10 | ≤0.20 | — | | |
| 32 | 2.2 | | ≤0.10 | — | 0.15 | ≤0.40 | — | ≤0.10 | ≤0.10 | — | | |
| 33 | 2.8 | | ≤0.10 | — | 0.35 | ≤0.40 | — | ≤0.10 | ≤0.10 | — | 4.93 | 1.33% O |
| 34 | 4.0 | | 0.4 | ≤0.15 | 0.05 | ≤0.40 | — | ≤0.10 | ≤0.25 | — | | |
| 35 | 4.9 | | 1.0 | ≤0.15 | 0.25 | ≤0.40 | — | ≤0.10 | ≤0.25 | — | | |
| 36 | 3.5 | | 0.2 | ≤0.15 | 0.05 | ≤0.50 | — | ≤0.10 | ≤0.25 | — | | |
| 37 | 4.5 | | 0.7 | ≤0.15 | 0.25 | ≤0.50 | — | ≤0.10 | ≤0.25 | | 5.87 | 1.58% O |
| 38 | 3.1 | | ≤0.50 | ≤0.20 | ≤0.25 | ≤0.50 | — | ≤0.10 | ≤0.20 | — | | |
| 39 | 3.9 | | ≤0.50 | ≤0.20 | ≤0.25 | ≤0.50 | — | ≤0.10 | ≤0.20 | — | | |
| 40 | 4.0 | | 0.2 | ≤0.10 | ≤0.10 | ≤0.35 | — | ≤0.15 | ≤0.25 | — | 2.72 | 0.73% O |
| 41 | 5.0 | | 0.5 | ≤0.10 | ≤0.10 | ≤0.35 | — | ≤0.15 | ≤0.25 | | | |
| 42 | 1.7 | | 0.1 | ≤0.15 | ≤0.15 | ≤0.50 | — | ≤0.15 | ≤0.15 | — | | |
| 43 | 2.6 | | 0.6 | ≤0.20 | 0.1 | ≤0.40 | — | ≤0.10 | ≤0.25 | — | | |
| 44 | 2.9 | | ≤0.50 | ≤0.15 | ≤0.30 | ≤0.40 | — | ≤0.10 | ≤0.20 | — | 4.89 | 1.32% O |
| 45 | 0.6 | | ≤0.50 | ≤0.10 | ≤0.30 | ≤0.35 | — | ≤0.30 | ≤0.20 | — | | |
| 46 | 0.4 | | ≤0.20 | ≤0.15 | ≤0.10 | ≤0.50 | — | ≤0.20 | ≤0.20 | — | | |
| 47 | 0.52 | | ≤0.10 | ≤0.10 | ≤0.05 | 0.2 | — | ≤0.10 | ≤0.15 | — | | |
| 48 | 0.9 | | ≤0.15 | ≤0.15 | 0.1 | ≤0.7 | — | 0.25 | ≤0.25 | — | 5.01 | 1.35% O |
| 49 | 0.6 | | ≤0.10 | ≤0.10 | ≤0.10 | ≤0.35 | — | ≤0.10 | ≤0.10 | — | | |
| 50 | 0.8 | | 0.4 | ≤0.10 | ≤0.25 | ≤0.50 | — | ≤0.10 | ≤0.20 | — | | |
| 51 | 0.7 | | 0.05 | ≤0.10 | ≤0.20 | ≤0.35 | — | ≤0.25 | ≤0.15 | — | | |
| 52 | 2.5 | | ≤0.10 | ≤0.06 | ≤0.05 | ≤0.15 | ≤0.05 | 1.9 | 5.9 | — | 3.28 | 0.88% O |
| 53 | 1.2 | | 0.1 | — | 0.19 | ≤0.40 | — | ≤0.20 | 4.8 | — | | |
| 54 | 2.5 | | ≤0.30 | ≤0.20 | 0.19 | ≤0.50 | — | 1.4 | 5.4 | — | | |
| 55 | ≤0.05 | | ≤0.05 | ≤0.05 | — | ≤0.40 | — | ≤0.05 | ≤0.07 | — | 2.15 | 0.58% O |

AA—referes to the sum of % Y + % Sc + % REE

Illustrative example of different natures tested for each single alloy overall composition following the strategies of example 18:

Alloy 3 as a single plasma atomized powder with a +1/−15 micron distribution (D50=9 micron).

Alloy 3 as a mixture of 1 centrifugal atomized powder and 1 gas atomized powder —both with the composition of alloy 3-70% with a size D50=310 microns and 30% with a size of D50=18 microns.

Alloy 3 as a mixture: 55% of crushed powder with the composition of Alloy 3 except for % Si, % Cu and % Zn and D50=60 microns, 35% of pure aluminum centrifugal atomized powder (D50=12 microns), 1% of 50Si50Al master-alloy (50=15 microns), 0.6% of 50Cu50Al master-alloy (D50=14 microns), 8.4% of a centrifugal atomized powder with the required composition to match an overall composition of alloy 3 (D50=16 microns).

Etc.

Example 29. Several Magnesium base alloys were tested. The different strategies in terms of powder and powder mixtures described in this document were tested, amongst others all the strategies described in example 18 were tested for every single overall composition in the table below. The list of alloys tested is more than a hundred pages long, for the sake of extension only the composition of the powder tested or the overall composition of the mix, when powder mixtures were employed, is listed and only for a few representative cases. In all the tests with alloys listed in the table following the strategies of example 18 at least one relevant characteristic was better in comparison to the exactly same composition melt in the LAB with a laboratory arc melting furnace—Edmund Bühler GmbH Arc Melter AM200—Also in most of the cases when following the strategies of example 18 and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| # | % Al | % Fe | % Zn | % Cu | % Si | % Mn | % Ni | % Li | % Ag | AA | OTHERS |
|---|---|---|---|---|---|---|---|---|---|---|---|
| 1 | 8.5 | 0.004 | 0.45 | 0.025 | 0.05 | 0.17 | 0.001 | 0.5 | | 1.29 | 0.35% O |
| 2 | 9.5 | 0.004 | 0.9 | 0.025 | 0.05 | 0.40 | 0.001 | | | | |
| 3 | 5.6 | 0.004 | 0.20 | 0.008 | 0.05 | 0.26 | 0.001 | | | | |
| 4 | 6.4 | 0.004 | 0.20 | 0.008 | 0.05 | 0.5 | 0.001 | | | | |
| 5 | 4.5 | 0.004 | 0.20 | 0.008 | 0.005 | 0.28 | 0.001 | | | 2.49 | 0.67% O |
| 6 | 5.3 | 0.004 | 0.20 | 0.008 | 0.005 | 0.5 | 0.001 | 2.3 | | | |
| 7 | 3.7 | 0.003 | 0.10 | 0.015 | 0.6 | 0.35 | 0.001 | | | | |
| 8 | 4.8 | 0.003 | 0.10 | 0.015 | 1.4 | 0.6 | 0.001 | | | 4.98 | 1.34% O |
| 9 | 5.5 | | | | | | | 12.0 | 1.0 | | |

AA—referes to the sum of % Y + % Sc + % REE

Illustrative example of different natures tested for each single alloy overall composition following the strategies of example 18:

Alloy 3 as a single gas atomized powder (D50=129 micron).

Alloy 3 as a mixture of 1 centrifugal atomized powder and 1 plasma atomized powder —both with the composition of alloy 3-70% with a size D50=1200 microns and 30% with a size of D50=58 microns.

Etc.

Example 30. Several Metal Matrix Composites were tested. They consisted on metallic alloys reinforced with hard particles. Often the amount of particles was much larger than the amount of metallic ligant. The different strategies in terms of powder and powder mixtures described in this document were tested, amongst others all the strategies described in example 18 were tested for every single overall composition in the table below. The list of alloys tested is long, for the sake of extension only the composition of the powder tested or the overall composition of the mix, when powder mixtures were employed, is listed and only for a few representative cases. In all the tests with alloys listed in the table following the strategies of example 18 at least one relevant characteristic was better in comparison to the exactly same composition processed conventional as a Hard-metal or carbide for tools. Also in most of the cases when following the strategies of example 18 and either 3, 4, 8, 12, 13, 14 or 15 better toughness related performance that equivalent materials additively manufactured were attained. That was always the case when the strategies of example 8 were incorporated—even more so when the Pressure and/or Temperature treatment was done incorporating the strategies described in example 9. That was always also the case when the strategies of example 10 were incorporated.

| | | | | | | | | | Mixed | |
|---|---|---|---|---|---|---|---|---|---|---|
| # | % Ni | % Co | % Fe | % Cu | % WC | % MoC | % VC | % TiC | Carbides | OTHERS |
| 1 | 5.5 | 12.0 | — | — | 80.5 | — | 2 | — | | |
| 2 | — | — | 18.8 | — | 80.0 | 1.2 | — | — | | |
| 3 | 1.1 | 0.5 | 80.3 | — | 2.1 | — | 1 | 15 | | |
| 4 | — | 1.3 | 35 | 5.5 | 15 | 3.2 | — | 40 | | |
| 5 | 2.2 | — | 35.2 | 3.2 | 2.3 | — | 38.9 | — | | |
| 6 | 13.2 | 1.2 | 40.8 | — | 3.1 | | — | — | | |
| 7 | 3.4 | — | 56.4 | — | 12.3 | 4.6 | 41.7 | — | | |
| 8 | — | — | 54.8 | 1.7 | 15.1 | — | 28.7 | — | | |
| 9 | — | 9.8 | 60.5 | — | 23.2 | 6.5 | — | — | | |
| 10 | — | — | 80.2 | 12.5 | 7.3 | — | — | — | | |

AA—referes to the sum of % Y + % Sc + % REE

Illustrative example of different natures tested for each single alloy overall composition following the strategies of example 18:

MMC 1 as a single gas atomized powder (D50=259 micron).

MMC 1 as a mixture of 1 centrifugal atomized powder and 1 plasma atomized powder —both with the composition of MMC 1-70% with a size D50=32 microns and 30% with a size of D50=4 microns.

MMC 1 as a mixture of 80.5% Tungsten carbide powder—from chemical reaction at high temperature— (D50=0.6 microns), 2.0% Vanadium carbide powder—from chemical reaction at high temperature— (D50=0.8 microns), 5% electrolytic Ni powder with a size D50=22 microns and 12% gas atomized pure cobalt (D50-18 microns).

Etc.

Example 31.

Several structural components and some dies were manufactured using additive manufacturing methods comprising a metallic material in particulate or wire form (technologies based on bed fusion—PBF— like DMLS, SLM, EBM, and even SLS; technologies based on direct energy deposition—DED—, in this case several technologies based on different welding principles were also tested; Joule printing was also tested; also some heads with some of the technologies mentioned in this paragraph were mounted on very large printers for BAAM), while it was possible to achieve satisfactory results with all of these technologies, several provided good results and a few provided exceptional results. Some of these structural components and dies comprised cooling channels which were manufactured using the strategies of example 5. Some components were of large size, and amongst them some were constructed following the indications of example 6, while it was possible to achieve satisfactory results with all of these strategies, several provided good results and a few provided exceptional results. The metal comprising materials described in this document were used, amongst many others the materials described in examples 1, 3, 4, 11 to 15 and 16 to 30 were tested, while it was possible to achieve satisfactory results with all of these metal comprising materials, several provided good results and a few provided exceptional results. The geometrical aspects described in this document were tested amongst them those elaborated in example 7. Certain particular advantages were found depending on the technology and materials used, but the performance was ensured regardless of the technology and materials employed.

Amongst all the examples one has been chosen to better exemplify this technology. Special attention was put in the construction of some structural components for ships and moving machines, for this purpose two technologies were priorized, joule printing and also DED—in particular a BAAM machine with a laser head capable of printing both powder and wire. The material used was a construction steel with only % Mn and % C as purposefully added alloying elements and % S, % P, % Si, % Cr, % Cu, % Ni and a few others as unavoidable impurities and thus tolerated to a certain limit. % Cu, % Ni, % Cr and all those impurities were limited to 0.15%, % Si to 0.5%, % S, and % P to 0.035%. % C ranged from 0.12% to 0.21% and the range 0.15 to 0.21% was preferred. % Mn ranged from 0.1% to 0.8% and the range 0.2% to 0.7% was preferred. Some powder and wire batches were made with the addition of micro alloying, where small amounts of % Al, % Ti, % Nb and/or % V were added to improve mechanical properties, but quantities were always below 0.2%. An effort was placed to optimize the parameters to avoid pores and thus attain higher densities while trying to minimize the HAZ—Heat Affected Zone—provoked on the existing layers. The results were acceptable in yield strength but short in elongation for some of the applications originally envisioned. To try to overcome those shortcomings several Pressure and/or Temperature treatment were tested replicating the ones explained in examples 1, 8 and 9, together with several % O and % N fixing treatments replicating the ones applied in example 3 [NOTE-1], obtaining a noticeable and rather unexpected improvement. Some of the specimens went further processing with a High Temperature/High Pressure treatment (several were tested: most following the indications of example 14 and some following the indications of example 10) also some specimens that had not been subjected to the Pressure and/or Temperature treatment underwent a % O and % N fixing treatment, several were tested, replicating the ones applied in example 3 [NOTE-1] and then were also applied the High Temperature/High Pressure treatment (several tested, again most following the indications of example 14 and some following the indications of example 10). In practically all cases there was an increase in elongation and in several cases the values obtained were already satisfactory.

[NOTE-1]: The fixing steps were tailored to match those of example 3 and consequentially the same levels of % O and % N were achieved. What was noticeably different and thus worth reporting to avoid confusion are the Apparent Densities, % NMVC and reduction of both % NMVC and % NMVS values reported. Only some of the tests of this example underwent full consolidation treatment. Basically, in example 3 some values of Apparent Density (AD), % NMVC and reduction of % NMVS are reported after consolidation treatment, in the current example those values were AD—(most of the tests between 91% and full density, many tests between 94.2% and full density, several tests between 96.4% and 99.8%, some between 99.4% and full density), % NMVC—(most of the tests between 0.002% and 9%, many tests between 0.006% and 0.9%, several between 0.02% and 0.4%, a few at 0%), reduction of % NMVS—(most of the tests above 0.12%, several above 0.6% and some above 6%). Also in example 3 some values of AD, % NMVC and reduction of both % NMVC and % NMVS are reported after High Pressure and High Temperature treatment, in the current example those values were AD—(most of the tests between 96% and full density, many tests between 98.2% and full density, several tests between 99.2% and 99.98%, some between 99.82% and full density), % NMVC—(most of the tests between 0.002% and 1.9%, many tests between 0.006% and 0.8%, several between 0.01% and 0.09%, some at 0%), reduction of % NMVS—(most of the tests above 0.02%, several above 0.22% and some above 2.6%), reduction of % NMVC—(most of the tests above 0.06%, several above 0.12% k and some above 6%).

1. A method for manufacturing at least part of a metal comprising component, which method comprises the following steps:
providing a mold at least partly manufactured by additive manufacturing;
filling the mold with a powder or powder mixture comprising at least a metal or a metal alloy in powdered form;
a forming step, wherein the component is formed by applying a pressure and/or temperature treatment to the mold;
a debinding step, wherein at least part of the mold is eliminated; and
a consolidation step, wherein a consolidation treatment is applied.

2. The method according to claim 1, further comprising a fixing step after the debinding step, wherein the oxygen and/or nitrogen level of the metallic part of the component is set.

3. The method according to claim 1, further comprising a densification step after the consolidation step.

4. The method according to claim 1, further comprising a step of applying a heat treatment and/or a machining.

5. The method according to claim 1, wherein the consolidation step is applied to achieve a right apparent density higher than 81% and lower than 99.6%.

6. The method according to claim 1, wherein the forming step comprises applying a pressure between 60 MPa and 1200 MPa.

7. The method according to claim 1, wherein the oxygen content in the powder or powder mixture is above 620 ppm.

8. The method according to claim 2, wherein the oxygen content in the metallic part of the component after the fixing step is more than 0.2 ppm and less than 390 ppm.

9. The method according to claim 2, wherein the % NMVS in the metallic part of the component after the fixing step is more than 31%.

10. The method according to claim 2, wherein the fixing step comprises the application of a vacuum with an absolute pressure of 0.9*10¹ mbar or lower and 0.9*10⁻¹⁰ mbar or higher.

11. The method according to claim 3, wherein the % NMVC in the metallic part of the component after the densification step is less than 9%.

12. The method according to claim 1, wherein the significant cross-section of the manufactured component is more than 0.2 mm² and less than a 49% of the area of the largest rectangular face of a rectangular cuboid with the minimum possible volume which contains the manufactured component.

13. The method according to claim 1, wherein the significant cross-section of the component is the mean cross-section obtained when the 20% of the largest cross-sections and the 20% of the smallest cross-sections are not considered to calculate the mean cross-section.

14. The method according to claim 1, wherein a metal comprising powder mixture that comprises carbonyl iron powder is employed.

15. (canceled)

16. (canceled)

17. (canceled)

18. (canceled)

19. The method according to claim 1, wherein the powder mixture comprises at least two different nature powders.

20. The method according to claim 1, wherein the powder mixture comprises at least two powders mixed together with a significant difference in the content of at least one critical element.

21. The method according to claim 1, wherein the powder mixture comprises at least two powders in the right proportion to each other, both in the same base but one larger and more irregular than the other.

22. (canceled)

23. (canceled)

24. (canceled)

25. (canceled)

26. (canceled)

27. (canceled)

28. The method according to claim 1, wherein the method comprises the reduction of the oxygen and/or nitrogen level in a system employing microwaves as the main power source for heating of the powder.

29. The method according to claim 1, wherein the method comprises microwave heating.

30. (canceled)

31. (canceled)

32. (canceled)

33. (canceled)

34. The method according to claim 1, further comprising a step of joining different parts to make a bigger component before the consolidation step, carbonyl iron powder is employed.
